(19) United States
(12) Patent Application Publication
(10) Pub. No.: US 2026/0141783 A1
(43) Pub. Date: May 21, 2026

(54) MYSTERY JACKPOT TECHNIQUES IMPLEMENTED AT LIVE DEALER CASINO GAME TABLES (LDGTS) AND LIVE DEALER-CONTROLLED ELECTRONIC TABLE GAMES SYSTEMS (DETGS) COMPRISING MULTIPLE ELECTRONIC TABLE GAME TERMINALS (ETGTS)

(71) Applicant: Tech (Macau) Limited, Macau (MO)

(72) Inventors: Jay Chun, Hong Kong (HK); Hon Man Au, Coloane (MO); David Y. So, Macau (MO)

(73) Assignee: Tech (Macau) Limited, Macau (MO)

(21) Appl. No.: 19/394,814

(22) Filed: Nov. 19, 2025

Related U.S. Application Data
(60) Provisional application No. 63/722,531, filed on Nov. 19, 2024.

(51) Int. Cl. G07F 17/32

(52) U.S. Cl. CPC G07F 17/3258

(57) ABSTRACT

A comprehensive wager-based gaming system configured to implement “Mystery” Jackpot” techniques at live dealer casino game tables (LDGTS) and live dealer-controlled electronic table games systems (DETGS) comprising multiple electronic table game terminals (ETGTS). A central Core Module coordinates interactions between Electronic Table Game Terminals, mobile devices, and live Dealer Consoles. The Dealer Console features a manual trigger for system-wide jackpots, gated by a Dealer Performance Tracker that validates game analytics. A Multi-Game State Synchronization Algorithm manages disparate game cycles to synchronize event animations. The system further includes a Sandboxed Verification Module for ingesting external sponsor funds into prize pools and a Jackpot Odds Adjustment Engine that dynamically modifies random number generator parameters based on player loyalty metrics. Additionally, a Physical Proximity Tracking System utilizes sensor fusion to verify spatial adjacency for distributing location-based community bonuses.

### RELATED APPLICATION DATA

The present application claims benefit, pursuant to the provisions of 35 U.S.C. § 119, of U.S. Provisional Application Ser. No. 63/722,531 (Attorney Docket No. LTG1P012P), titled “MYSTERY JACKPOT TECHNIQUES IMPLEMENTED AT LIVE DEALER CASINO GAME TABLES (LDGTS) AND LIVE DEALER-CONTROLLED ELECTRONIC TABLE GAMES SYSTEMS (DETGS) COMPRISING MULTIPLE ELECTRONIC TABLE GAME TERMINALS (ETGTS)”, naming Chun et al. as inventors, and filed 19 Nov. 2024, the entirety of which is incorporated herein by reference for all purposes.

### BACKGROUND

The present invention relates to methods and apparatus for wager-based gameplay in casino environments, specifically at Live Dealer Casino Game Tables (LDGTS) and Live Dealer-Controlled Electronic Table Game Systems (DETGS).

Card games like blackjack, poker, and baccarat are fundamental to casinos, offering players various wagering opportunities. Traditionally played on physical tables with live dealers, these games have designated wagering areas for multiple players. While their simple rules make them widely accessible, they also limit the variety of wagering options, which may reduce player engagement and restrict potential profits for casinos.

To enhance player experience and operational efficiency, casinos have introduced LDGTS and DETGS. LDGTS feature live dealers conducting games broadcast to remote players who place wagers electronically. DETGS are electronic gaming systems controlled by live dealers, allowing player interaction through electronic interfaces either on-site or remotely. Despite these advancements, the limited wagering options of traditional card games remain unchanged in these formats, potentially leading to decreased player interest and limited revenue growth. The embodiments described herein address these issues.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices, systems, and networks according to various embodiments.

FIG. 3A is a block diagram depicting various functional elements of an EGM in an example embodiment.

FIG. 3B depicts a casino gaming environment in an example embodiment.

FIG. 4 is a diagram of components of a system for providing online gaming in an example embodiment.

FIG. 5 illustrates, in block diagram form, an implementation of a game processing architecture algorithm that implements a game processing pipeline for the play of a game in accordance with various implementations described herein.

FIG. 6 illustrates an example embodiment of a Gaming Network 600 which may be configured or designed to implement various automated money laundering detection and reporting techniques described and/or referenced herein.

FIG. 7 shows an example block diagram of an electronic gaming system 700 in accordance with a specific embodiment.

FIG. 8 shows electronic gaming table 760 with various features, in accordance with a specific embodiment.

FIG. 9 shows a block diagram of electronic gaming device 900, in accordance with a specific embodiment.

FIG. 10 is a simplified block diagram of an exemplary intelligent electronic gaming system 1000 in accordance with a specific embodiment.

FIG. 11 is a simplified block diagram of an exemplary mobile gaming device 1100 in accordance with a specific embodiment.

FIG. 12 illustrates an example of a functional block diagram of a Casino Gaming Server System in accordance with a specific embodiment.

FIG. 13 illustrates an alternate example embodiment of a Gaming Network 1300 which may be configured or designed to implement various automated money laundering detection and reporting techniques described and/or referenced herein.

FIG. 14 shows a block diagram illustrating components of a gaming system which may be used for implementing various aspects of example embodiments.

FIG. 15 shows an embodiment of the overall design of a baccarat Dealer-controlled Electronic Table Game (“DETG” or betting terminal).

FIG. 16 shows a wager-based gaming system embodying live baccarat jackpot.

FIG. 17 shows an embodiment of the design of the dealing table of a DETG system.

FIG. 18 shows an embodiment of one design of a Live Baccarat DETG.

FIG. 19 shows an embodiment of another design of the Live Baccarat DETG.

FIG. 20 illustrates an example embodiment of a network architecture and component interaction diagram of a Casino Gaming Network Portion 2050.

Additional Figures depict various system diagrams, flow diagrams, and screenshots of graphical user interfaces which have been configured or designed to facilitate, enable, initiate, and/or perform one or more operation(s), action(s), and/or feature(s) of the various Mystery Jackpot (MJP) techniques described herein.

### DETAILED DESCRIPTION OF EXAMPLE EMBODIMENTS

### Overview

Various aspects described or referenced herein are directed to different methods, systems, and computer program products directed to electronic gaming devices and Mystery Jackpot (MJP) techniques implemented in a wager-based gaming networks.

Some aspects described or referenced herein are directed to different techniques for facilitating managing synchronized mystery progressive jackpots in a live dealer-controlled gaming environment. One aspect disclosed herein is directed to a system for managing synchronized mystery progressive jackpots in a live dealer-controlled gaming environment. In at least one embodiment, one or more aspects disclosed herein are directed to a system including a central gaming network, a plurality of electronic table game terminals connected to the central gaming network, each electronic table game terminal being operable for receiving a player wager on a base game; and a dealer console physically situated proximate to a live dealer and communicatively coupled to the central gaming network, the dealer console comprising a biometric authentication scanner and a trusted platform module. The system further includes a first server system comprising a processor and a dealer performance tracker module, and a non-transitory memory storing a progressive jackpot pool. The first server system is operable for continuously monitoring game outcomes to update a dealer performance metric of the live dealer via the dealer performance tracker module; electronically enabling a physical trigger mechanism on the dealer console only when the dealer performance metric meets a predefined threshold condition; and receiving a cryptographically signed manual trigger signal from the dealer console, wherein the cryptographically signed manual trigger signal comprises a biometric hash of the live dealer verified by the trusted platform module. In response to receiving the cryptographically signed manual trigger signal, the system executes a multi-game state synchronization protocol by: (i) broadcasting a lock-state command to the plurality of electronic table game terminals; (ii) suspending independent game cycles on the plurality of electronic table game terminals upon completion of a current active hand; (iii) receiving a ready-state acknowledgement from the plurality of electronic table game terminals; and (iv) upon receiving the ready-state acknowledgement, executing a random number generator (RNG) evaluation to determine a mystery jackpot outcome and transmitting a synchronized execution command to the plurality of electronic table game terminals to display the mystery jackpot outcome simultaneously.

In at least one embodiment, the dealer console comprises a bonus activation interface, and the cryptographically signed manual trigger signal is initiated by the live dealer pressing a button on the bonus activation interface.

In at least one embodiment, the at least one processor is adapted to execute additional instructions for temporarily enhancing a contribution rate of player wagers to the progressive jackpot pool for a limited time period following the initiating of the cryptographically signed manual trigger signal.

In at least one embodiment, the mystery jackpot outcome comprises the first server system applying a temporary win multiplier to the progressive jackpot pool for a defined number of subsequent game rounds.

In at least one embodiment, the plurality of electronic table game terminals are configured for playing a plurality of different game types, and the first server system performs the step of transmitting the lock-state command simultaneously to the plurality of electronic table game terminals running disparate game types.

In at least one embodiment, the cryptographically signed manual trigger signal initiates a jackpot bonus round, and the at least one processor is adapted to execute additional instructions for temporarily altering betting parameters for the jackpot bonus round.

In at least one embodiment, the dealer console is a live dealer control panel, and the first server system receives the cryptographically signed manual trigger signal from the live dealer control panel.

Additional aspects described or referenced herein are directed to different techniques for facilitating managing externally funded progressive jackpots in a secure networked gaming environment. One aspect disclosed herein is directed to a system for managing externally funded progressive jackpots in a secure networked gaming environment. In at least one embodiment, one or more aspects disclosed herein are directed to a system including a secure internal casino gaming network, a plurality of electronic table game terminals connected to the secure internal casino gaming network; and a sandboxed verification module located within a demilitarized zone of the secure networked gaming environment, the sandboxed verification module being configured to interface with an external third-party sponsor system. The system further includes a first server system comprising a processor located within the secure internal casino gaming network, the first server system being connected to the sandboxed verification module via a unidirectional message bus; and a non-transitory memory storing a shadow ledger associated with a progressive jackpot pool. The sandboxed verification module is operable for: (i) receiving an external data payload from the external third-party sponsor system containing funding parameters; (ii) performing a deep packet inspection and schema validation on the external data payload; (iii) sanitizing the external data payload by stripping executable code and metadata to create a sanitized internal payload; (iv) translating the sanitized internal payload into an internal binary protocol message; and (v) pushing the internal binary protocol message to the unidirectional message bus. The first server system is operable for consuming the internal binary protocol message from the unidirectional message bus; updating the shadow ledger associated with the progressive jackpot pool to reflect the funding parameters without commingling the external data payload with internal game logic; and transmitting a command to the plurality of electronic table game terminals to display promotional graphics associated with the external third-party sponsor system only upon successful validation of the funding parameters.

In at least one embodiment, the at least one processor is adapted to execute additional instructions for verifying a social media action of a player using an external social media platform, wherein the social media action is a non-wagering activity.

In at least one embodiment, the at least one processor is adapted to execute additional instructions for, upon successful verification of the social media action, dynamically adjusting a set of eligibility criteria for the player regarding the progressive jackpot pool.

In at least one embodiment, the step of dynamically adjusting comprises the first server system increasing a set of odds of the player being selected as a jackpot winner.

In at least one embodiment, the funding parameters are received in exchange for displaying sponsor branding on a dynamic user interface of one of the plurality of electronic table game terminals during a jackpot growth phase.

In at least one embodiment, the at least one processor is adapted to execute additional instructions for applying a wagering credit to a player account associated with the player in exchange for the player completing a referral via the external social media platform.

In at least one embodiment, the at least one processor is adapted to execute additional instructions for determining a mystery trigger independent of a base game outcome.

In at least one embodiment, the promotional graphics are displayed on the plurality of electronic table game terminals only when the progressive jackpot pool exceeds a predetermined threshold.

In at least one embodiment, the external third-party sponsor system is a non-casino brand.

Additional aspects described or referenced herein are directed to different techniques for facilitating managing personalized mystery progressive jackpots using real-time probability modification. One aspect disclosed herein is directed to a system for managing personalized mystery progressive jackpots using real-time probability modification. In at least one embodiment, one or more aspects disclosed herein are directed to a system including a plurality of electronic table game terminals, each electronic table game terminal being operable for a player participating in a wagering game; a player tracking server storing a VIP status for the player; a jackpot odds adjustment engine comprising a high-frequency stream processing application; and a first server system comprising a processor and an eligibility tracker. The first server system is operable for: receiving player identity data and corresponding VIP status for the player from the player tracking server in real-time; tracking a plurality of real-time player activity metrics for the player, including wager velocity, session duration, and theoretical loss; constructing a state vector representing a current session profile of the player; inputting the state vector into the jackpot odds adjustment engine to calculate a personalized probability modifier using a non-linear weighting function; dynamically re-weighting an acceptance range of a random number generator (RNG) by applying the personalized probability modifier to a base trigger threshold; and executing the RNG using the re-weighted acceptance range to determine if a mystery jackpot event is triggered for the player, thereby technically modifying the probability of the mystery jackpot event based on the real-time player activity metrics.

In at least one embodiment, the at least one processor is adapted to execute additional instructions for determining a time-limited jackpot activation window that is available only to players having a VIP status above a predefined tier.

In at least one embodiment, the at least one processor is adapted to execute additional instructions for locking a set of non-qualifying player terminals out of the time-limited jackpot activation window.

In at least one embodiment, the personalized probability modifier increases the probability of the player winning the mystery jackpot event as a play frequency of the player increases.

In at least one embodiment, the at least one processor is adapted to execute additional instructions for dynamically granting the player access to a higher-value jackpot pool only upon the player reaching a VIP status above a predefined threshold.

In at least one embodiment, the at least one processor is adapted to execute additional instructions for, in response to the mystery jackpot event being triggered, calculating a payout amount and applying a VIP-based multiplier to the payout amount based on the VIP status of the player.

In at least one embodiment, the plurality of electronic table game terminals are connected across a multi-casino progressive network managed by the first server system.

In at least one embodiment, the personalized probability modifier is generated by the jackpot odds adjustment engine analyzing a historical win/loss ratio of the player.

Additional aspects described or referenced herein are directed to different techniques for facilitating managing a spatially-aware progressive jackpot in a networked electronic table game environment. One aspect disclosed herein is directed to a system for managing a spatially-aware progressive jackpot in a networked electronic table game environment. In at least one embodiment, one or more aspects disclosed herein are directed to a system including a live dealer table, and a plurality of electronic table game terminals located at the live dealer table, each electronic table game terminal being operable for receiving player wagers and being associated with a physical seating position, wherein each electronic table game terminal comprises an integrated proximity sensor array. The system further includes a physical proximity tracking system configured to maintain a real-time topology map of the physical seating positions of a plurality of active players based on signals from the integrated proximity sensor arrays. The system also includes a first server system comprising a processor, a wager contribution system and a player activity tracker. The first server system is operable for monitoring a count of concurrent active players placing wagers within a specific timeframe using the player activity tracker; calculating a dynamic contribution rate using a logistic sigmoid function based on the count of concurrent active players to apply hysteresis and prevent rapid fluctuation of a growth rate of a shared progressive jackpot pool; receiving a trigger signal for the shared progressive jackpot pool and identifying a primary jackpot winner at a triggering electronic table game terminal; querying the real-time topology map to identify a set of verified adjacent electronic table game terminals physically proximate to the triggering electronic table game terminal; validating a presence of an adjacent player at each of the verified adjacent electronic table game terminals using the signals from the integrated proximity sensor arrays; and automatically distributing a portion of the shared progressive jackpot pool to the adjacent players at the verified adjacent electronic table game terminals based on the validating of the presence of the adjacent player.

In at least one embodiment, the shared progressive jackpot pool aggregates contributions from the plurality of electronic table game terminals running disparate game types.

In at least one embodiment, each of the adjacent players automatically receives a fixed percentage share of the shared progressive jackpot pool, regardless of whether the adjacent player was the primary jackpot winner.

In at least one embodiment, the primary jackpot winner receives a first percentage share of the shared progressive jackpot pool and the adjacent players collectively receive a second percentage share of the shared progressive jackpot pool.

In at least one embodiment, the plurality of electronic table game terminals are networked across multiple distinct casino properties.

In at least one embodiment, the at least one processor is adapted to execute additional instructions for calculating the portion of the shared progressive jackpot pool for each of the adjacent players based on a cumulative wager contribution of the adjacent player to the shared progressive jackpot pool over a predefined period.

In at least one embodiment, the calculating of the dynamic contribution rate is achieved by increasing a percentage of each player's wager contributed to the shared progressive jackpot pool.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that may be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

The invention discloses a comprehensive Wager-Based Gaming System designed to bridge the operational gap between live-dealer table games and electronic wagering interfaces. The specific technological purpose of this system is to integrate the high-energy, human-centric experience of physical casino floors with the precision, scalability, and automated mechanics of electronic gaming networks. At the heart of this invention is a “First Server System” or Core Module that orchestrates complex interactions between disparate gaming terminals, mobile devices, live dealer consoles, and external data sources. The system functionality extends beyond standard wagering to include novel control topologies where human dealers actively trigger system-wide events, external economic sources such as sponsors fund prize pools, and player loyalty metrics dynamically alter the mathematical probabilities of random number generators in real-time. The system is designed to support a hybrid environment where local players at physical Electronic Table Game Terminals (ETGTs) and remote players via mobile applications participate synchronously in the same gaming events, sharing not just the game outcomes but also community-based bonuses and jackpot states.

The disclosed technology addresses several specific technical problems inherent in prior art gaming systems. A primary issue addressed is “engagement decay” in automated systems, where the repetitive, algorithmic nature of electronic gaming leads to player fatigue. Traditional systems also struggle with the technical difficulty of synchronizing major events, like jackpots, across heterogeneous networks where devices have varying latencies and game cycles (e.g., synchronizing a slow-paced Roulette wheel with a fast-paced Baccarat hand). Furthermore, prior art systems lack a secure method for integrating external, non-wagering data-such as social media actions or third-party financial injections-into the regulated, high-security gaming logic without compromising the integrity of the Random Number Generator (RNG). Finally, standard systems utilize static probability models that fail to account for individual player behavior or loyalty in real-time, leading to suboptimal retention of high-value clients.

To solve these problems, the invention introduces four primary innovative elements. First, it implements a Dealer-Controlled Jackpot Activation system where a live dealer's discretionary input, validated by a Dealer Performance Tracker (DPT), acts as the trigger for a synchronized system-wide event. Second, it employs a Sandboxed Verification Module to securely ingest funds from third-party sponsors and validation tokens from social media platforms, effectively decoupling prize pool growth from player wagers alone. Third, the system utilizes a Jackpot Odds Adjustment Engine (JOAE) that dynamically re-weights RNG parameters based on predictive Lifetime Value (LTV) models, offering personalized odds to specific players. Fourth, the system features a Dynamic Jackpot Pooling mechanism driven by player concurrency metrics and a Physical Proximity Tracking System that utilizes sensor fusion to verify and reward players spatially adjacent to a jackpot winner. These innovations collectively create a responsive, immersive, and secure gaming ecosystem that adapts to the physical and digital environment in real-time.

### Architectural Overview

The architecture of the Wager-Based Gaming System is centered around the Core Module, often referred to as the First Server System, which acts as the central orchestrator for all game logic, state management, and network synchronization. This module connects to a diverse array of endpoints including physical Electronic Table Game Terminals (ETGTs) located on the casino floor, remote player interfaces accessible via web or mobile applications, and specialized Dealer Consoles located at live gaming tables. The Dealer Console is an important hardware component equipped with a dedicated “Event Trigger” button, biometric authentication scanners (such as fingerprint readers), and a visual interface that displays the status of the Dealer Performance Tracker (DPT). The DPT is a logic subsystem that continuously monitors game outcomes, such as dealer win streaks, to electronically enable or disable the manual trigger button, ensuring that human control is logically gated by game analytics.

Operational flow within the system is managed through a series of specialized subsystems and protocols. For the Dealer-Controlled Jackpot, the system employs a Multi-Game State Synchronization Algorithm. When a dealer activates the trigger, the Core Module broadcasts a “Prepare” signal to all connected terminals. Terminals in an idle state lock immediately, while terminals in an active game state complete their current cycle before locking. The system utilizes a “Two-Phase Commit” logic to ensure all clients are synchronized before executing the jackpot animation, utilizing a jitter buffer to mask network latency between local and remote players. For external integrations, the system utilizes a Sandboxed Verification Module (SVM) located in a Demilitarized Zone (DMZ). This module acts as a secure gateway that sanitizes incoming data from third-party sponsors or social media APIs, translating external webhooks into internal binary commands via a unidirectional message bus, thereby protecting the internal game logic from external cyber threats.

The technical specifications of the system include advanced sensor and processing capabilities. The Physical Proximity Tracking System (PPTS) integrates Bluetooth Low Energy (BLE) beacon arrays and NFC/RFID readers embedded in the ETGTs to triangulate player locations and verify physical adjacency for “Neighbor Luck Share” bonuses. The Jackpot Odds Adjustment Engine (JOAE) functions as a high-frequency stream processing application, ingesting player telemetry such as wager velocity and theoretical loss to calculate a Personalized Probability Modifier using non-linear mathematical functions like hyperbolic tangents. This engine modifies the acceptance range of the RNG for specific sessions in real-time. Additionally, the system includes a Distributed Timer System and a Fund Redistribution Engine that manage the lifecycle of jackpot claims, automatically recirculating expired or unclaimed funds back into active pools according to deterministic rules to maintain regulatory compliance and economic equilibrium.

### Noteworthy & Novel Concepts

Dealer-Controlled Jackpot Activation Integrated with Electronic Table Game Systems

This concept introduces a control topology where a live dealer acts as the primary initiator for a system-wide electronic jackpot event. Unlike conventional systems where jackpots are triggered solely by internal algorithms, this invention bridges the gap between human intuition and machine precision. The implementation involves a Dealer Console equipped with biometric security and a Dealer Performance Tracker (DPT). The DPT acts as a logic gate, monitoring real-time game analytics such as consecutive dealer wins to technically enable or disable the manual trigger button. This ensures that the dealer's discretionary input is tied to the narrative flow of the game while preventing arbitrary use. A significant technical novelty is the Multi-Game State Synchronization protocol, which creates a “Wait-and-Lock” state across a heterogeneous network. This protocol allows the system to pause disparate games—such as Roulette and Baccarat—at safe intervals to synchronize a high-fidelity jackpot animation for both local and remote players simultaneously, mitigating the technical challenges of latency and game cycle disparity.

### External Funding Mechanisms for Jackpot Pools

This innovative element defines a secure framework for funding jackpot pools through non-wagering sources, specifically third-party sponsors and social media engagements. It creates an “open-loop” financial architecture where external capital drives prize growth, distinguishing it from the closed-loop systems of prior art. The implementation relies on a Sandboxed Verification Module (SVM) positioned within a network DMZ. This module utilizes a “Logical Air-Gap” protocol to ingest and sanitize data from external APIs. For example, it verifies cryptographic signatures from social media webhooks to confirm a player has shared a game link, subsequently translating this action into an internal command that improves the player's jackpot eligibility or odds. Similarly, it manages secure financial handshakes with sponsor banking systems to inject funds into the jackpot meter while simultaneously deploying branded advertising content to the player terminals. This architecture solves the “Oracle Problem” in gaming by securely validating external world data without exposing the important RNG and accounting servers to public internet threats.

### Loyalty-Based Dynamic Jackpot Odds Modification

This concept fundamentally alters the probabilistic mechanics of the gaming system by transitioning from a static “one-size-fits-all” probability model to a dynamic, personalized model. The system implements a Jackpot Odds Adjustment Engine (JOAE) that intercepts the standard RNG process. Instead of using fixed lookup tables, the JOAE executes a real-time adaptive algorithm that processes player-specific metrics-such as loyalty tier, churn probability, and session loss rate—to calculate a unique probability modifier. This modifier re-weights the RNG hit thresholds for that specific player's session, effectively changing the “physics” of the chance engine to optimize retention and reward loyalty. The implementation may require high-frequency computation to perform these multi-variate optimizations within the millisecond-level game logic window. Furthermore, the system includes an Eligibility Tracker that creates parallel game state views, allowing high-value players to access exclusive jackpot pools or “Time-Limited Windows” that are invisible to standard players on the same network.

### Dynamic Jackpot Pooling and Sharing Based on Player Metrics and Physical Proximity

This element introduces a living economic ecosystem where the behavior of the jackpot pool is governed by real-time environmental data. The invention features a Dynamic Acceleration Algorithm that adjusts the jackpot contribution rate based on the total volume of active players, utilizing a non-linear logistic curve to accelerate prize growth during high concurrency. This is managed by a PID controller logic with hysteresis to prevent system instability from rapid fluctuations in player counts. Simultaneously, the system implements a “Neighbor Luck Share” mechanic driven by a Physical Proximity Tracking System (PPTS). By fusing data from BLE beacons, RFID readers, and a static topology map of the casino floor, the system may deterministically verify which players are physically seated adjacent to a jackpot winner. This allows the system to distribute “Community Bonuses” based on verified spatial relationships rather than simple logical connectivity, preventing fraud and fostering a communal gaming atmosphere that extends to virtual “neighbors” playing remotely.

### Technical Improvements & Advantages

The Wager-Based Gaming System provides significant technical improvements over existing solutions, particularly in the areas of network synchronization, security, and algorithmic efficiency. The Multi-Game State Synchronization Algorithm solves the concurrency conflict problem inherent in linking different game types, reducing network congestion and processing errors associated with race conditions. By implementing a “Timeout Fallback” and a “Jitter Buffer,” the system improves resilience against network latency, ensuring that slow connections do not disrupt the visual integrity of the floor-wide event. Security is vastly improved through the Sandboxed Verification Module and the Cryptographic Dealer Command Protocol. The use of a Trusted Platform Module (TPM) to sign dealer inputs creates an undeniable audit trail, while the SVM's protocol translation protects the specific gaming logic from web-based attacks such as SQL injection or cross-site scripting. Additionally, the Jackpot Odds Adjustment Engine introduces a stateful RNG context, optimizing the allocation of the prize budget by mathematically targeting “luck” toward players with the highest predicted lifetime value, a capability absent in stateless prior art systems.

The primary benefits of the invention include enhanced player engagement, operational flexibility, and robust regulatory compliance. The system combats “engagement decay” by introducing human-initiated unpredictability and dynamic pacing that mirrors the excitement of live tables. The ability to integrate external sponsors and social media actions provides new revenue streams and acquisition channels, transforming the gaming terminal into a hybrid media consumption device. From an operational standpoint, the automated management of unclaimed funds via the Distributed Timer System ensures that resources are efficiently recycled without manual intervention, while the auditable logs generated by the dealer console and proximity sensors provide the transparency required by gaming regulators. The system's ability to scale seamlessly from physical floor operations to remote mobile play allows casinos to maximize the utilization of their gaming assets and liquidity, regardless of physical foot traffic.

### Use Cases & Potential Applications

The primary application for this invention is within the regulated casino industry, specifically in “Hybrid” or “Omni-Channel” gaming environments. Large-scale integrated resorts, such as those in Macau or Las Vegas, would utilize this system to link their physical baccarat, roulette, and blackjack tables with their online gaming platforms. The Dealer-Controlled Jackpot is particularly suited for high-stakes VIP rooms where the dealer plays a central role in the entertainment experience. The External Funding Mechanisms allow casinos to host sponsored events, such as “Luxury Brand Weeks,” where jackpots are funded by advertisers rather than player losses. The Loyalty-Based Odds engine is applicable across the entire casino floor to automate player retention strategies, dynamically rewarding players who are at risk of churning.

Alternative applications for this technology extend to other forms of networked gaming and interactive entertainment. The “Neighbor Luck Share” and proximity tracking concepts may be applied to eSports arenas or stadium betting, where physical location determines eligibility for location-based prizes. The secure ingestion of external data via the Sandboxed Verification Module may be adapted for “Skill-Based Gaming” or “Gamified Finance” applications where real-world events (e.g., sports scores, stock market movements) need to trigger regulated payouts in a secure manner. Furthermore, the synchronization algorithms developed for linking heterogeneous game cycles may find utility in other distributed real-time systems requiring precise visual coordination across diverse client devices, such as interactive live-streaming platforms or massively multiplayer online games.

The LIVE Dealer-Controlled Multiplayer Games with Mystery Jackpot (MJP) features, concepts and techniques disclosed herein introduce a host of innovations that distinguish it from prior art. Its ability to integrate across multiple game types, enable flexible jackpot triggers and eligibility criteria, and offer varied funding and distribution methods represents a leap forward in table game jackpot systems. Notable benefits of this system include enhanced player engagement, increased wagering activity, and a more exciting and communal gaming experience. Additionally, its compatibility with live dealer and electronic table systems makes it adaptable to a wide range of casino environments. By combining elements of randomness, skill, and social interaction, the Mystery Jackpot system delivers a unique and compelling gaming experience that traditional systems cannot match.

The LIVE Dealer-Controlled Multiplayer Games with Mystery Jackpot features represent an advanced system integrated into live dealer-controlled multiplayer games, including both Live Dealer Game Tables (LDGTs) and Dealer-controlled Electronic Table Game Systems (DETGs) comprising multiple Electronic Table Game Terminals (ETGTs). This system enables unique Mystery Jackpot mechanics that create dynamic and exciting gameplay experiences by incorporating elements of randomness, multiple-player interaction, and diverse game types. A brief summary of various features, functionalities, and benefits of the DETG Mystery Jackpot techniques is described below

### Example DETG Mystery Jackpot Innovative Concepts

The Mystery Jackpot Innovative concepts integrated into DETGs include multiple innovative approaches that expand beyond conventional jackpot systems. These concepts involve the use of progressive and multi-casino networks, player engagement features, and flexible configurations for operators. Some notable Innovative concepts include:
Multi-Casino Progressive Mystery Jackpot: This involves linking multiple casinos through a shared network, where DETGs across different locations contribute to a single progressive jackpot. The system tracks player engagement across locations in real-time and triggers a jackpot when a certain player threshold is reached. This multi-property integration provides a sense of shared excitement across different geographic locations.
Side Bet-Driven Mystery Jackpot Funding: Players' side bets contribute to the jackpot pool, allowing for quick accumulation. This method also creates a sense of involvement for players as they know their bets directly impact the jackpot size.
Cumulative Sequential Player Participation: In this system, the jackpot is awarded when a predefined number of players participate sequentially over a certain time. This concept adds a layer of excitement, as players realize their gameplay is actively contributing to a shared goal.
Player-Selectable Jackpot Modes: Players may select different jackpot participation modes, allowing for a tailored experience where they choose between individual payouts or group-based jackpots. This offers a more personalized gaming experience.
Cross-Game Jackpot Eligibility: Players may qualify for the Mystery Jackpot by participating across multiple game types (e.g., blackjack, baccarat), thus fostering more diverse engagement. This differs from traditional systems that limit eligibility to a single game.

These concepts highlight the flexibility and scalability of the Mystery Jackpot system, which enables multiple use cases that enhance engagement for both players and casinos.

### Example Mystery Jackpot Eligibility Criteria

Eligibility for the Mystery Jackpot may be based on a wide array of criteria, designed to engage a diverse range of players and to reward different styles of gameplay. Some examples include:
Time-Based Participation: Players are eligible if they participate in games during specific time windows, such as a “golden hour”. This drives player activity during off-peak hours, increasing overall game traffic.
Session Duration: Players who continuously play for a specified period (e.g., 30 minutes) may become eligible, encouraging longer playtimes.
High Roller Eligibility: This feature rewards players who consistently place high-value bets. Such criteria incentivize larger wagers, directly benefiting the casino's revenue.
VIP Status: VIP players or those with higher loyalty tier standings may gain special access to the Mystery Jackpot. This feature enhances customer retention and loyalty programs by offering exclusive benefits.

These diverse eligibility criteria ensure that the Mystery Jackpot system may cater to both casual players and high-rollers, providing equal opportunities for participation while driving player retention.

### Example Mystery Jackpot Triggering Criteria

Triggering a Mystery Jackpot in the system involves various mechanisms, each designed to add layers of randomness, excitement, and fairness to the gameplay. Some of the innovative triggering criteria include:
Cumulative Wager Threshold: A jackpot is triggered once a cumulative total wager across all DETGs in the casino reaches a predefined threshold. This mechanism fosters a communal sense of achievement as players contribute towards unlocking the jackpot.
Random Timer-Based Trigger: The jackpot may be activated randomly after a certain period of gameplay, maintaining an element of surprise.
Simultaneous Player Bet Match: The Mystery Jackpot may trigger if multiple players place identical bets simultaneously. This creates shared moments of anticipation among players.
Game-Specific Trigger: A jackpot may be awarded when a specific card combination or game outcome occurs, making each game round exciting as players anticipate a potential jackpot event.

These criteria introduce novelty by moving beyond static jackpot triggers based solely on wagering or winning outcomes, creating excitement through unpredictable and varied conditions.

### Example Mystery Jackpot Funding Techniques

The Mystery Jackpot is funded through a variety of methods that encourage participation from players while ensuring that the jackpot grows rapidly over time. Notable funding techniques include:
Side Bet Contributions: A portion of side bets placed during gameplay is allocated to the jackpot pool. This is particularly effective as side bets are often lower in value, yet collectively significant, ensuring steady growth of the jackpot.
Tiered Bet Contributions: Contributions to the jackpot pool scale according to the size of the wager. High-rollers may contribute more, incentivizing larger bets.
Progressive Wager Matching: The system may match a percentage of player wagers and allocate this to the jackpot. This progressive matching accelerates jackpot accumulation and player engagement.
Loyalty Points Conversion: Players may opt to convert loyalty points into jackpot contributions, allowing them to leverage non-monetary rewards.

These funding techniques create a dynamic and transparent system where players may see how their actions contribute to the growing jackpot, driving engagement and sustained interest.

### Example Mystery Jackpot Distribution Techniques

Once the Mystery Jackpot is triggered, the system uses a variety of methods to distribute the jackpot among players. These distribution techniques include:
Bet Proportional Distribution: The jackpot is distributed proportionally based on the size of each players wagers. This encourages higher betting and rewards players who contribute more significantly to the jackpot pool.
Last Bet Multiplier: The player who placed the last bet before the jackpot was triggered may receive a bonus payout. This creates urgency in gameplay as players aim to be the last to bet.
Skill-Based Distribution: Some jackpots may reward players based on their performance in the game, such as achieving specific skill-based milestones. This adds an element of skill to the traditionally luck-based system.
Neighbor Luck Share: Players sitting adjacent to the jackpot winner may also receive a share of the jackpot, fostering a sense of community and shared excitement at the table.

These techniques allow for flexibility in payout structures, enabling operators to tailor the system to different player segments and enhance the social aspects of the gaming experience.

### Example Mystery Jackpot Enabling/Disabling Techniques

Operators have full control over when and how the Mystery Jackpot is enabled or disabled, allowing for dynamic control based on player activity and business objectives. Some of the enabling/disabling criteria include:
Time-Limited Enabling Windows: The jackpot is only enabled during specific time windows (e.g., peak casino hours). This creates urgency and drives traffic during high-traffic periods.
Jackpot Pool Size Trigger: The jackpot becomes enabled once the pool reaches a certain size. This ensures that players are incentivized to engage when the jackpot has reached an appealing amount.
High Bet Activation: The jackpot may only be enabled when players place bets above a certain threshold. This promotes higher betting activity during gameplay.

These enabling/disabling features offer operational flexibility and allow casinos to optimize the system to maximize player engagement while controlling jackpot payouts.

Innovative Element 1—Dealer-Controlled Jackpot Activation Integrated with Electronic Table Game Systems

This Innovative Element defines a specialized control subsystem within the Wager-Based Gaming System that empowers a live dealer to manually initiate system-wide jackpot events through a physical or digital interface on the dealer console. Its specific purpose is to bridge the gap between the high-energy, human-centric experience of live table games and the precision, scalability, and automated mechanics of electronic wagering systems. In conventional systems, jackpots are triggered exclusively by internal game logic (e.g., a specific hand) or random background algorithms. This Innovative Element introduces a human-in-the-loop control flow where the dealer's discretionary input acts as the primary trigger signal, which is then validated and processed by the central system to execute a random jackpot event. This creates a practical application by transforming the dealer's role from a passive game facilitator to an active game controller who may strategically influence the pacing and excitement of the electronic gaming floor. The computer is integral to this invention because it must receive the manual signal, instantly perform complex probability calculations using a Random Number Generator (RNG), synchronize the game state across a heterogeneous network of Electronic Table Game Terminals (ETGTs) running different games, and broadcast the jackpot event in real-time to both local and remote players.

Within the Wager-Based Gaming System, which integrates local and remote play, this element is implemented by equipping the live dealer's station with a specialized “Bonus Activation Interface.” This interface is securely connected to the Wager-Based Gaming System Core Module. When the dealer activates the trigger (e.g., pressing a “Mystery Jackpot” button during a lull in play or after a significant win streak), the system does not guarantee a payout but instead initiates a probability check. If successful, the system executes a “Multi-Game State Synchronization” protocol to momentarily interrupt or overlay the base game on all connected physical ETGTs and remote player interfaces (web/mobile). This ensures that a dealer in a physical casino may simultaneously engage a local player sitting at a terminal and a remote player betting via a smartphone, creating a unified, high-excitement event that transcends the physical location. This functionality provides operational flexibility for casinos to manage floor energy and addresses the technical problem of “engagement decay” in automated systems by injecting human unpredictability.

### Sequence Diagram Components:

Local Player: A player physically present at the casino, interacting with the Wager-Based Gaming System through a physical ETGT. They receive visual cues from the dealer and the terminal display.

Remote Player: A player accessing the live game stream via a web or mobile interface. They participate in the same dealer-controlled games and jackpot events as local players, receiving synchronized video and data feeds.

Live Dealer: The human operator managing the physical game table. They are equipped with a Dealer Console that includes the manual jackpot trigger mechanism.

Dealer Console: The hardware interface used by the Live Dealer. It includes the “Random Jackpot Activation Button” (physical or touchscreen) and a display for system feedback, such as jackpot readiness status.

Physical EGM/ETGT: The gaming terminal on the casino floor. It runs the base game software, accepts wagers, and renders the jackpot animations triggered by the system.

Wager-Based Gaming System Core Module: The central server acting as the “First Server System.” It manages the state of all connected terminals, processes the dealer's trigger signal, executes the RNG probability check, and coordinates the jackpot distribution.

Dealer Performance Tracker (DPT): A logic module within the Core Module that monitors game outcomes and dealer metrics (e.g., consecutive wins, game pace) to determine when the manual trigger button should be enabled or disabled.

Random Number Generator (RNG): A certified hardware or software component that generates the random outcome (Win/No Win and Prize Amount) upon receiving the dealer's trigger signal.

Video Streaming Server: Captures the live video of the dealer (including their interaction with the activation button) and streams it with low latency to Remote Players and potentially to local displays.

Casino Backend System: The central database and management system that handles player account balances, transaction logging, and regulatory reporting for both local and remote wagers.

### Implementation Details:

The implementation of Dealer-Controlled Jackpot Activation within the Wager-Based Gaming System may require a sophisticated integration of hardware and software to ensure security, synchronization, and responsiveness. On the hardware side, the Dealer Console is modified to include a dedicated, industrial-grade input mechanism, such as a large physical button or a specific zone on a capacitive touchscreen, designated as the “Jackpot Trigger.” Regarding security implementation details, this console integrates a biometric authentication scanner (e.g., fingerprint reader) or a secure RFID card reader. The dealer may be authenticated before the trigger input is accepted by the system, preventing unauthorized access. The console is hardwired to the table's logic controller, which communicates with the Wager-Based Gaming System Core Module via a secure, private local area network (LAN) using encrypted protocols (e.g., TLS 1.3) to prevent signal interception or spoofing.

The software architecture is built around the “First Server System,” which hosts the Wager-Based Gaming System Core Module. This module includes the Dealer Performance Tracker (DPT). The DPT continuously ingests game result data from the table. It implements specific operational logic: the manual trigger button is logically “locked” (disabled) by default. It only becomes “unlocked” (enabled) when specific conditions are met, such as “Dealer wins 5 consecutive hands” or “Table handle exceeds $10,000 in the last hour.” The Dealer Console UI displays a status indicator (e.g., a greyed-out button turning red) to visually inform the dealer when the trigger is available.

Upon receiving a valid, authenticated trigger signal from the console, the Core Module executes the Multi-Game State Synchronization algorithm. Since connected ETGTs may be running different base games (e.g., some on Roulette, others on Baccarat) with different game cycles, the system cannot simply pause gameplay instantly. Instead, the synchronization algorithm broadcasts a “Pending Jackpot Event” state to all terminals. Each terminal allows the current game round (e.g., the current spin or hand) to complete. Once a terminal reaches an “Idle” or “Betting Open” state, it enters a “Jackpot Lockout” mode, displaying a “Jackpot Event Initiated by Dealer!” overlay. The Core Module waits for a “Ready” signal from all participating terminals (local and remote) or a timeout threshold before executing the RNG draw. This ensures that the jackpot event is presented synchronously to all players without disrupting active game logic. For Remote Players, the Video Streaming Server synchronizes the video feed with the data overlay, ensuring the visual of the dealer pressing the button aligns with the UI animation on the player's screen.

### Example Walk-Through Scenario:

The scenario begins at a high-stakes Baccarat table in a Macau casino. The Live Dealer has just won the 5th consecutive hand against the table. The Dealer Performance Tracker (DPT) running on the Wager-Based Gaming System Core Module detects this “5-win streak” condition. It sends an “Enable Trigger” signal to the Dealer Console. The previously dim “Mystery Jackpot” button on the console illuminates, pulsing to indicate readiness.

The Dealer, noticing the indicator and sensing the tension at the table, decides to escalate the excitement. She announces to the local players and the camera (for Remote Players), “The Banker is on fire! Let's see if we may turn this luck around with a Jackpot!” She places her thumb on the biometric scanner of the console to authenticate, then presses the “Mystery Jackpot” button.

The Dealer Console sends an encrypted trigger signal to the Core Module. The Core Module immediately validates the dealer's ID and the DPT condition. It then broadcasts a “Jackpot State: Pending” message to all 50 connected ETGTs (20 local, 30 remote via mobile app). Local Player A is mid-bet; her terminal finishes the countdown and deals the hand. Remote Player B is between hands; his screen immediately transitions to the Jackpot overlay. Within 3 seconds, all terminals report “Ready” status.

The Core Module calls the Random Number Generator (RNG). The RNG returns a “Positive Win” result with a prize tier of “Mini Jackpot.” The Core Module broadcasts the “Execute Win” command. Simultaneously, every ETGT screen and remote mobile interface erupts in a synchronized animation of gold coins. The Dealer's video feed is displayed prominently on the remote interfaces. The system selects Remote Player B as the winner. His screen flashes “YOU WIN!”, while Local Player A's screen shows “Remote Player B won the Jackpot!”. The Dealer receives a notification on her console: “Winner: Remote User ‘Dragon88’—$500.” She announces, “Congratulations to Dragon88 for hitting the Mini Jackpot!” The system then releases the lockout, and normal Baccarat gameplay resumes.

### Player Interaction:

Local Players interact with the system through the high-definition touchscreen of the physical ETGT. During standard play, the interface shows the betting layout. When the Dealer Performance Tracker enables the jackpot button, a small “Jackpot Ready” icon may appear on the player's screen to build anticipation. When the dealer presses the button, the player's UI is overtaken by a “Jackpot Event” overlay. They are temporarily blocked from placing standard bets. They watch the animation and the result. If they win, the credit meter updates instantly.

Remote Players interact via a dedicated mobile app or web browser. Their interface includes a live video window of the dealer. When the event triggers, the video window may expand or be framed by a special graphical border. The betting interface is disabled. They receive the same visual feedback as local players but optimized for a smaller screen. Crucially, the interaction includes a “Return to Game” button or automatic transition that seamlessly places them back into the betting lobby for the next hand, ensuring the flow between the jackpot interruption and the base game is smooth. This unified UI behavior ensures that remote players feel as much a part of the dealer-led ritual as those on the casino floor.

### Distinguishing Innovative Elements:

The specific novelty of this element lies in the specific control topology where a discretionary human input acts as the primary initiator for a system-wide, RNG-governed electronic event. Prior art in ETGTs typically relies on fully automated triggers (e.g., hitting a specific hand, a timer expiring, or a progressive pool reaching a cap). This system introduces a hybrid control mechanism: the dealer acts as a human “randomizer” for timing, while the computer remains the “randomizer” for the outcome. This specific decoupling—human timing, machine outcome—is technically novel in the context of regulated gaming systems because it may require the system to secure and validate a non-deterministic human input (the button press) and translate it into a deterministic system state change (the jackpot mode).

Furthermore, the integration of the Dealer Performance Tracker (DPT) as a logic gate for this manual input is a significant innovation. It transforms the button from a simple “on/off” switch into a context-aware gaming tool. The system does not just allow the dealer to press the button; it technically enforces when the button may be pressed based on real-time game analytics (e.g., win streaks). This creates a feedback loop between the game state (monitored by the server) and the control interface (operated by the dealer) that is absent in conventional systems where dealer interfaces are primarily for game administration (e.g., “no more bets”).

### Distinguishing Inventive Steps:

The inventive process involves three specific, non-obvious steps executed by the Wager-Based Gaming System:
1. Conditional Logic Gating of Manual Input: The First Server System (Core Module) continuously executes a monitoring process (DPT) that evaluates live game metrics against a ruleset (e.g., “Dealer Wins >5”). It dynamically sends “Enable/Disable” signals to the physical Dealer Console hardware. This step prevents arbitrary or abusive use of the trigger and ties the manual event technically to the game's flow.
2. Asynchronous-to-Synchronous State Transition: Upon receiving the manual trigger, the system executes a specialized “Wait-and-Lock” protocol. It converts the asynchronous state of multiple independent game terminals (where players are at different stages of a bet) into a synchronous “Jackpot Mode.” This involves sending a “Complete Current Action then Pause” command, waiting for acknowledgment signals from all clients, and then executing the event simultaneously. This synchronization step is important for fairness and user experience in a multi-game environment and is not found in standard standalone machines.
3. Hybrid Event Execution: The system executes a two-stage validation for the jackpot. First, it cryptographically verifies the dealer's identity (via biometric/RFID input) attached to the trigger signal. Second, it performs an RNG probability check. The jackpot is not guaranteed by the button press; the press only initiates the request for a jackpot. The system's logic to process a human request for a random outcome involves a specific sequence of API calls that isolate the human input from the RNG seed to ensure regulatory compliance (game integrity).

### Technical Improvements to Existing Technical Problems:

1. Problem: “Engagement Decay” in Automated Systems. Conventional electronic gaming systems rely on repetitive, automated cycles. Players may experience fatigue or “engagement decay” due to the predictable, algorithmic nature of bonuses.
   Solution: This Innovative Element introduces discretionary, human-initiated interruption. By allowing the dealer to trigger events based on the “vibe” or table outcomes, the system breaks the algorithmic monotony.
   Technical Advancement: This represents an improvement in Human-Computer Interaction (HCI) within gaming. The system enables a new input modality (discretionary dealer trigger) that dynamically alters the execution path of the gaming software, creating a non-deterministic pacing that mirrors the psychological engagement of physical table games while maintaining electronic accounting.
2. Problem: Latency and Synchronization in Hybrid Play. In systems allowing both local and remote play, synchronizing a major event like a jackpot across devices with varying network latencies (e.g., a hardwired slot machine vs. a 4G mobile phone) is technically difficult. A standard broadcast may result in local players celebrating while remote players are still betting.
   Solution: The Multi-Game State Synchronization protocol implements a “pre-notification and lock” state. The manual trigger doesn't fire the jackpot immediately, it fires a “prepare” command.
   Technical Advancement: This improves networked state management. By introducing a deterministic “lockout” phase triggered by the manual input, the system mitigates network latency issues. It forces all clients to align to a single state vector before the bandwidth-intensive jackpot animation is triggered, ensuring visual and logical consistency across the heterogeneous network.
3. Problem: Security of Human Inputs in Random Systems. Allowing a human to trigger a payout creates a vulnerability to collusion or fraud (e.g., a dealer signaling a confederate).
   Solution: The system implements conditional logic gating (DPT) and biometric authentication. The button is electronically disabled unless specific, system-verified game conditions are met, and the actuation is cryptographically signed by the dealer's ID.
   Technical Advancement: This improves system security and integrity. It creates a hardware-software “permissive link” where human input is treated as an untrusted variable that may be validated against internal logic states before being processed, preventing manipulation of the gaming outcome.

### Data Input:

The Wager-Based Gaming System processes specific novel data inputs for this element. From the Live Dealer, the system receives a discrete digital signal representing the “Button Press Event,” coupled with a “Dealer ID” and “Authentication Token” derived from the biometric/RFID scan. This input is novel because it is a control command for a random event, not a game administration command. From the Electronic Table Game Terminals (ETGTs), the system receives real-time “Game State Status” packets (e.g., “Idle,” “Betting,” “Dealing”). This input is important for the synchronization logic. From the Casino Backend, the system ingests “Configuration Parameters” for the Dealer Performance Tracker, such as the threshold for consecutive wins required to unlock the button. The system also inputs “Jackpot Pool Data” to determine the prize value to be displayed during the manual trigger event.

### Component Interactions and Procedural Steps:

1. Initiation: The Dealer Performance Tracker (DPT) within the Wager-Based Gaming System Core Module continuously analyzes game results. When the “5 Dealer Wins” threshold is crossed, the Core Module sends an enable_trigger command to the Dealer Console.
2. Dealer Action: The Dealer sees the button light up. She places her finger on the scanner and presses the button. The Dealer Console verifies the fingerprint locally and sends a secure trigger_request message (containing dealer_id, auth_token, timestamp) to the Core Module.
3. Validation & Synchronization: The Core Module verifies the token. It then multicasts a state_lock_request to all registered Physical EGM/ETGTs and the Remote Player Interface server.
4. Lockout: Each EGM/ETGT completes its current micro-process (e.g., finishing a card flip) and enters a “Locked” state, sending a state ready acknowledgement back to the Core Module.
5. Execution: Once the Core Module receives state_ready from a quorum of terminals (or a timeout expires), it calls the Random Number Generator.
6. Broadcast: The Core Module sends an execute_jackpot_event payload (containing win_status, winner_id, amount) to all endpoints.
7. Presentation: The Video Streaming Server overlays the jackpot graphics on the video feed. The EGM/ETGTs render the local animations.
8. Settlement: The Casino Backend System processes the transaction if a win occurred, crediting the winner's wallet.

### Data Processing:

The Wager-Based Gaming System Core Module performs important data processing. It runs the Dealer Performance Tracker algorithm, which is a state machine that transitions based on a stream of game result integers (1 for Dealer Win, 0 for Player Win). It calculates the streak count N. If N>=Threshold, it changes the state of the trigger enabled boolean. Upon receiving a trigger, the Core Module performs a cryptographic verification of the dealer's auth token against the stored hash in the database. The Multi-Game State Synchronization logic involves maintaining a real-time registry of the state of every connected terminal (e.g., a hash map of terminal_id->current state) to determine when the network is safe to interrupt. Finally, the RNG processing involves taking a seed (potentially influenced by the timestamp of the manual button press to ensure randomness) to generate the outcome.

### Outputs and Responses:

The system generates synchronized outputs to multiple endpoints. For the Local Player, the physical EGM/ETGT screen transitions from the betting layout to a full-screen “Jackpot Mode” animation, displaying the potential prize. For the Remote Player, the mobile app displays a “Jackpot Event In Progress” overlay that may obscure the betting controls but keeps the live video feed visible. The Dealer Console receives a haptic or visual confirmation (e.g., button flashes green) indicating the system accepted the trigger. If a win occurs, the Casino Backend System receives a “Jackpot Transaction Record,” and the Main Casino Display (overhead signage) receives a command to display the winner's alias and amount.

### Data Storage and Reporting:

The system logs specific data points to the Casino Backend System database. This includes the Dealer Action Log (timestamp of button enable, timestamp of button press, Dealer ID), which is important for auditing dealer behavior and identifying potential collusion. The Game State Log records the exact game state of every terminal at the moment of interruption, ensuring that if a dispute arises (e.g., a player claims they were about to win a hand), the system may reconstruct the exact moment of the lockout. These logs are used for Operational Reporting to analyze the correlation between dealer-initiated jackpots and subsequent player retention/betting volume.

### Error Handling and Security Measures:

To handle network latency or disconnection, the synchronization protocol includes a “Timeout Fallback.” If a remote client does not respond with state ready within 200 ms, the Core Module excludes that client from the visual synchronization but processes their eligibility on the server side to ensure they don't miss a potential win. To prevent Double-Press Errors, the Dealer Console hardware implements a “debounce” logic, and the server enforces a “Cooldown Period” (e.g., 30 seconds) after a trigger event. Security measures include the biometric authentication and/or other security measures described and/or referenced herein. Additionally, the system uses Tamper Detection on the physical console, if the casing is opened or the connection severed, the Core Module triggers a “Security Alert” and disables the jackpot function globally to prevent hardware manipulation.

### End of Interaction:

The interaction concludes when the jackpot animation finishes. The Wager-Based Gaming System Core Module sends a state_unlock command to all terminals. The EGM/ETGTs revert to their previous state (e.g., the betting screen for the next hand). The Dealer Console indicator turns off (or reverts to “locked” status if the streak condition is reset). The Casino Backend System finalizes the financial transaction for the winner. The system is now reset and ready for the next game cycle or the next dealer-initiated event.

### Innovative Element 2—External Funding Mechanisms for Jackpot Pools

This Innovative Element defines a sophisticated financial and data integration framework within the Wager-Based Gaming System that enables the funding of mystery jackpot pools through external, non-wagering sources, specifically Third-Party Sponsors and Social Media engagements. Its specific purpose is to decouple the growth of the jackpot prize from the sole dependency on player wagers or casino revenue allocation, creating a new revenue stream and a dynamic engagement model. In conventional gaming systems, jackpots are closed-loop financial ecosystems. This Innovative Element introduces a secure, open-loop architecture where external capital (from luxury brands, corporate sponsors) is ingested and converted into wagering credits or prize value, and external user actions (social media shares, referrals) are validated to grant in-game jackpot eligibility. This provides a practical application by transforming the Electronic Table Game Terminal (ETGT) into a dual-purpose device: a wagering interface and a dynamic advertising platform where the advertising revenue directly fuels the player's potential winnings. The computer is integral to this invention as it must securely bridge the highly regulated, high-security domain of the casino gaming network with the low-security, public domains of third-party financial gateways and social media APIs without compromising game integrity.

Within the Wager-Based Gaming System, which integrates local and remote play, this element is implemented via a “Third-Party Sponsor System” and a “Social Media Integration System” that interface with the Casino Backend through a specialized “Sandboxed Verification Module.” This setup allows a remote player on a mobile device to share a game link on social media to instantly boost their jackpot odds on a live physical table, or a local player to compete for a “Mega Jackpot” funded entirely by a luxury watch brand displayed on their terminal. This contributes to the Wager-Based Gaming System goals by driving player acquisition through viral social loops and enabling “super-sized” jackpots that would be unsustainable through player bets alone, providing operational flexibility to host sponsored events.

### Sequence Diagram Components:

Local Player: A player at a physical ETGT who views sponsored content and participates in sponsored jackpots. They may use a mobile device to scan QR codes on the ETGT for social integration.

Remote Player: A player accessing the system via a web/mobile app who may directly perform social media actions (sharing, inviting) to influence their jackpot status.

Physical EGM/ETGT: The gaming terminal which renders dynamic promotional content (ads, logos) linked to the sponsor funding the current jackpot.

Wager-Based Gaming System Core Module: The central orchestrator that receives verified funding/eligibility data and updates the game state (jackpot value, player eligibility) accordingly.

Third-Party Sponsor System: An external server controlled by a sponsor brand (e.g., a luxury retailer) that initiates funding transfers and provides promotional assets (images, video).

Social Media Integration System: An external API interface (e.g., Facebook Graph API, WeChat API) that tracks and reports player social actions.

Sandboxed Verification Module: An important security component within the casino network DMZ (Demilitarized Zone) that validates external data inputs (funds, social actions) before passing sanitized instructions to the Core Module, isolating the specific gaming logic from external threats.

Casino Backend System: Manages the financial ledger for sponsored funds and updates player loyalty profiles based on social engagement.

Ad Content Server: A dedicated content delivery system that serves the promotional media to the Physical EGM/ETGTs and Remote Player Interfaces.

### Implementation Details:

The implementation of External Funding Mechanisms may require a rigorous security architecture to address security protocols for external funding mechanisms. The Wager-Based Gaming System employs a Sandboxed Verification Module positioned between the external internet and the internal casino operations network (CON). This module functions as a unidirectional security gateway.

For Third-Party Sponsored Contributions, the architecture utilizes a secure API Gateway. The Sponsor System authenticates via mutual TLS (mTLS) and uses secure tokens (e.g., OAuth 2.0 or custom signed JWTs) to authorize funding requests. When a sponsor commits funds (e.g., $50,000 for a “Golden Week” jackpot), the Sponsor System sends a transaction request to the API Gateway. The Sandboxed Verification Module validates the financial transaction with the Payment Gateway and, upon confirmation, sends a sanitized “Credit Inject” message to the Casino Backend System. The Backend System holds these funds in a segregated escrow account and instructs the Wager-Based Gaming System Core Module to increment the visible jackpot meter. Simultaneously, the Ad Content Server pushes the sponsor's branding assets to the local cache of the Physical EGMs/ETGTs and the Remote Player Interfaces. This ensures that the jackpot growth and the advertisement display are synchronized.

For Social Media Referral-Based Eligibility, the implementation involves deep linking and webhook listeners. When a Remote Player shares a game invite, the social platform triggers a webhook. The Sandboxed Verification Module receives this webhook. To prevent fraud (e.g., fake shares), it employs a hash signature verification method (checking the X-Hub-Signature header against a stored secret) to confirm the data originated from the valid social platform. Once verified, it strips all metadata except the Player ID and Action Type and passes a secure “Eligibility Flag” to the Core Module. The Core Module then dynamically adjusts the player's status (e.g., unlocking a specific jackpot tier).

Hardware modifications for the Physical EGM/ETGT include the integration of secondary display controllers or “Picture-in-Picture” capabilities to render high-definition promotional content without obscuring important game elements. For the Macau market, where luxury retail is prominent, the system enables specific “VIP Sponsor” modes where high-limit tables feature exclusive jackpots funded by luxury brands, with the ETGTs displaying QR codes that allow local players to “claim” exclusive retail offers related to the sponsor, bridging the gaming and retail experience.

### Example Walk-Through Scenario:

The scenario involves a “Luxury Auto” sponsored event on the Wager-Based Gaming System. A high-end car manufacturer sponsors a $100,000 add-on jackpot.
1. Sponsorship Injection: The Third-Party Sponsor System sends an API request with a $100,000 transfer token and a set of 4K video assets featuring a new sports car.
2. Verification: The Sandboxed Verification Module validates the financial token with the bank and scans the media assets for malware.
3. System Update: Upon validation, the Casino Backend System creates a “Sponsor Pool.” The Wager-Based Gaming System Core Module receives a “Pool Update” command.
4. Synchronization: The Core Module broadcasts a command to 500 connected Baccarat ETGTs (both physical and remote instances). The jackpot meters on all screens jump by $100,000. Simultaneously, the background of the betting interface transitions to the sponsor's branded theme, and a video ad plays in a non-intrusive window.
5. Social Interaction: Remote Player A, playing via a smartphone in a hotel room, sees a prompt: “Share this jackpot event to unlock 2× Odds!” Player A taps “Share to WeChat.”
6. Eligibility Boost: The Social Media Integration System detects the share and fires a webhook. The Sandboxed Verification Module validates the webhook signature. It sends an internal message: Player ID: A, Action: Share, Reward: 2×_Odds.
7. Outcome: The Core Module updates Player A's session state. On the next hand, Player A's interface displays a “2× Jackpot Odds Active” icon. Player A places a wager. The RNG evaluates the jackpot trigger with the boosted probability.
8. Local Interaction: Local Player B at a physical terminal sees the car ad and the massive jackpot. They scan a QR code on the terminal screen to “Follow the Sponsor” and receive a similar eligibility boost, linking their physical play to their digital social identity.

### Player Interaction:

Local Player: The physical ETGT screen features a dedicated “Sponsor Zone” or dynamic ticker. During a sponsored event, this area displays the sponsor's logo and the “Added Value” (e.g., “+$50,000 contributed by Brand X”). To participate in social eligibility, the player taps a “Boost My Odds” button, generating a dynamic QR code on the screen. They scan this with their personal mobile device to perform the social action (e.g., liking a page). The ETGT screen updates in real-time: “Social Boost Active!”

Remote Player: The web/mobile interface integrates promotional content natively. Banner ads or video interstitials may play during non-gameplay states (e.g., shuffling). The interface includes “Share” and “Invite” buttons directly overlaid on the game lobby. Feedback is immediate, upon sharing, a graphical animation (e.g., a glowing aura around the jackpot meter) confirms the eligibility upgrade. The player clearly sees the distinction between the “Base Jackpot” (funded by wagers) and the “Bonus Jackpot” (funded by the sponsor).

### Distinguishing Innovative Elements:

The specific novelty lies in the architectural integration of external, non-gaming economic sources into the regulated wagering loop. Prior art typically limits jackpot funding to internal sources (rake, coin—in). This element introduces a Commercial-Wagering Bridge, allowing third-party capital to directly alter the volatility and Expected Value (EV) of a gambling game in exchange for advertising impressions. This transforms the ETGT from a gambling machine into a hybrid media consumption device.

Additionally, the Social-Eligibility Feedback Loop is conceptually novel. In conventional systems, marketing actions (like sharing) may yield non-cash credits or loyalty points. In this Wager-Based Gaming System, these external actions directly manipulate the specific mathematical parameters of the game (jackpot eligibility or RNG probability weights) in real-time. This may require a level of secure data ingestion and logic processing not found in standard casino management systems, which rigidly separate marketing data from game logic to ensure compliance.

### Distinguishing Inventive Steps:

1. Sandboxed External Data Ingestion: The system performs a specific security step where external data packets (financial or social) are terminated, decrypted, and validated in a DMZ (Sandboxed Verification Module) before a new, internal command is generated for the Core Module. This “air-gap style” logic translation is non-obvious for gaming systems that usually reject all real-time external inputs.
2. Dynamic Media-to-Jackpot Synchronization: The system executes a synchronized procedure where the display of promotional media assets on the ETGT is technically locked to the presence of the sponsored funds in the active pool. If the sponsor funds are won, the system automatically and simultaneously purges the branded content from all terminals, ensuring the “advertising contract” (display for funds) is enforced algorithmically.
3. Verification-Based Logic Injection: The process of accepting a cryptographically signed webhook from a social platform and using it to instantaneously flip a boolean flag (Eligible: True) or modify a float variable (Odds: 1.5) in the active game memory of a running wagering session is a unique procedural step that merges social networking APIs with real-time gambling state machines.

### Technical Improvements to Existing Technical Problems:

1. Problem: Stagnant Jackpot Growth in Low-Liquidity Markets. In smaller casinos or off-peak hours, player-funded jackpots grow slowly, failing to attract engagement.
   Solution: External Funding Injection. The system allows instant, massive increases in jackpot size via sponsor injection, independent of player volume.
   Technical Advancement: This improves system scalability and engagement mechanics. By decoupling pool growth from transaction volume, the system may maintain high-value incentives during low-concurrency periods, optimizing the utilization of the gaming infrastructure.
2. Problem: Cyber-Security Risks of External Integrations. Connecting a regulated gaming server to the public internet (for social/sponsor APIs) introduces attack vectors for RNG manipulation or denial of service.
   Solution: Sandboxed Verification Module. The architecture isolates the Core Module. External signals are verified in a separate environment.
   Technical Advancement: This represents an improvement in computer security architecture for regulated industries. It enables rich external connectivity without expanding the attack surface of the important game logic generator, solving the tension between “connected features” and “regulatory isolation.”
3. Problem: Disconnect Between Digital Marketing and Floor Play. Digital marketing (social shares) usually results in delayed rewards (coupons) that don't drive immediate play on physical machines.
   Solution: Real-Time Eligibility Bridging. The system translates a digital action (share) into an immediate, tangible state change on the physical machine (odds boost) via the QR/Mobile handshake.
   Technical Advancement: This improves cross-platform data synchronization. It creates a real-time data pipe between a user's personal device context and the industrial gaming terminal's operating state, reducing the friction between “marketing conversion” and “active gameplay.”

### Data Input:

The system may require novel data inputs including Sponsor Transaction Objects (containing Fund Amount, Campaign ID, Duration, Media Asset Links) and Social Action Tokens (containing Platform ID, User Hash, Timestamp, Action Type). These inputs are novel because they originate from outside the casino's private network yet directly influence the internal game state. The system also ingests Player-Sponsor Affinity Data (e.g., does Player X interact with luxury car ads?) to target specific sponsored jackpots to specific terminals, optimizing the “yield” of the advertising space.

### Component Interactions and Procedural Steps:

1. Sponsor Initiation: The Third-Party Sponsor System sends a CreateCampaign request to the Casino Backend.
2. Security Check: The request hits the Sandboxed Verification Module, which validates the sponsor's digital signature and funds availability via the Payment Gateway.
3. Asset Deployment: Upon validation, the Backend instructs the Ad Content Server to push media to the Wager-Based Gaming System Core Module.
4. State Update: The Core Module updates the Global_Jackpot_Pool variable and sets the Active_Sponsor_ID.
5. Broadcast: The Core Module pushes a websocket message UpdateState(Jackpot+$X, ShowAd: True) to all Physical EGM/ETGTs and Remote Player Interfaces.
6. Social Trigger: A Remote Player clicks “Share”. The Remote Interface calls the social API.
7. Callback Processing: The Social Media Integration System receives the success callback and forwards a signed payload to the Sandboxed Verification Module.
8. Logic Injection: The Sandbox verifies the signature and sends an internal RPC call GrantBonus(PlayerID) to the Core Module.
9. Player Update: The Core Module modifies the active session object for that player, enabling the Jackpot_Boost_Active flag, which is immediately reflected on the player's UI.

### Data Processing:

The Sandboxed Verification Module performs cryptographic hashing (HMAC validation) to ensure data integrity from external sources. The Wager-Based Gaming System Core Module performs real-time allocation logic: determining how to split sponsored funds across different jackpot tiers (e.g., 80% to Grand, 20% to Mini). It also executes impression counting logic, tracking how many seconds the sponsor's logo is displayed on active terminals to report back on “Ad Value.” For social features, the system processes referral graphs, mapping relationships between players to determine if a referral chain leads to a jackpot eligibility event (e.g., “Player A is eligible because Player B, whom they referred, placed a bet”).

### Outputs and Responses:

The system outputs include Financial Credit Updates to the jackpot meters (visible to all). For the sponsor, the system generates Campaign Performance Reports (impressions, clicks). For the player, the system outputs State Change Notifications (e.g., “Boost Activated,” “Jackpot Sponsored by [Brand]”). Critically, the system sends Regulatory Audit Logs detailing exactly how much external money was added to the pool and confirming that the “Sponsored” funds were treated distinctly from player funds until the moment of the win.

### Data Storage and Reporting:

Data requiring persistent storage includes Sponsor Ledger Records (audit trail of external fund injection), Social Verification Logs (proof of the social action that granted eligibility), and Ad Impression Logs. This data is stored in secure, immutable tables within the Casino Backend System (e.g., SQL for financial, NoSQL for social logs). It is leveraged for Business Intelligence to determine which sponsors drive the most gameplay and for Regulatory Compliance to prove that the jackpot growth was legitimate and funded.

### Error Handling and Security Measures:

If the Third-Party Sponsor System fails to transfer funds after an ad campaign starts, the system executes an Automated Rollback: the Core Module pauses the “Sponsored” state, removes the added funds from the displayed meter (or covers them from a casino reserve if play has occurred), and removes the ads. If the Social Media API goes down, the system enters a Fallback Mode, granting eligibility based on alternative internal metrics (e.g., time played) to prevent player frustration. Security measures include Isolating the RNG: the external data (social actions) may change the threshold for a win, but it may never directly interact with the random number generation process itself. All external inputs are treated as “untrusted” until validated by the Sandbox.

End of Interaction: The interaction concludes when the Sponsored Jackpot is won or the Campaign Duration expires. The Wager-Based Gaming System Core Module sends a EndCampaign signal. The Physical EGM/ETGTs remove the sponsor branding and revert to the standard UI themes. The Casino Backend System reconciles the final ad impressions and sends a settlement report to the Third-Party Sponsor System. The specific jackpot pool associated with the sponsor is archived, and the system transitions back to the standard player-funded jackpot state.

### Innovative Element 3—Loyalty-Based Dynamic Jackpot Odds Modification and Exclusive Pool Access

This Innovative Element describes a highly specialized logic subsystem within the Wager-Based Gaming System that fundamentally alters the probabilistic mechanics of mystery jackpots based on individual player profiles. Its specific purpose is to transition jackpot systems from a static, “one-size-fits-all” probability model to a dynamic, personalized model where a player's specific loyalty tier, historical behavior, and real-time engagement directly influence their statistical likelihood of triggering a win or accessing specific prize pools. In conventional systems, Random Number Generators (RNGs) operate on fixed probability tables applicable to all active terminals equally. This Innovative Element introduces a variable probability engine where the RNG's “hit thresholds” are dynamically re-weighted in real-time by a “Jackpot Odds Adjustment Engine.” This creates a practical application by integrating the casino's Customer Relationship Management (CRM) data directly into the execution logic of the gaming machine, turning the jackpot system into an automated, algorithmic tool for maximizing Player Lifetime Value (LTV). The computer is integral to this invention because it must perform continuous, high-speed cross-referencing of massive player history databases with live game events to recalculate complex probability formulas for thousands of concurrent sessions without introducing latency that would disrupt the game.

Within the Wager-Based Gaming System, which supports both local physical play and remote mobile play, this functionality is implemented via the “Jackpot Odds Adjustment Engine” residing on the First Server System. This engine acts as a middleware between the Player Tracking Server and the Game Logic Processor. It allows, for instance, a remote VIP player accessing a live Macau baccarat table via a smartphone to have a mathematically higher probability of triggering a mystery jackpot than a local casual player at the same table, or to unlock an “Exclusive Platinum Jackpot Window” that is invisible and inaccessible to others. This contributes to the system's goals by providing operational flexibility to target high-value segments with algorithmic precision, solving the technical problem of player retention by creating personalized “luck” environments that reward sustained engagement.

### Sequence Diagram Components:

Local Player: A player physically present at the casino, identified via a loyalty card insert or biometric scan at the ETGT.

Remote Player: A player logged in via the casino's secure web/mobile app. Their identity is verified upon login, linking them to the same loyalty profile as their physical play.

Physical EGM/ETGT: The gaming terminal that acts as the user interface. It displays personalized jackpot odds and “unlocked” pools specific to the logged-in player.

Wager-Based Gaming System Core Module: The central orchestrator that manages the game state and queries the Odds Engine before executing any random mystery trigger determination.

Player Tracking Server (PTS): A database system storing static player attributes (Tier Level: Gold, Platinum) and dynamic historical metrics (Average Bet, Frequency of Visits, Theoretical Loss).

Jackpot Odds Adjustment Engine (JOAE): A specialized high-performance computing module that ingests player metrics and outputs a “Probability Modifier” or “RNG Seed Offset.”

Eligibility Tracker: A logic module that enforces access control rules for “Exclusive Pools” or “Time-Limited Windows,” acting as a gatekeeper based on the data from the PTS.

Random Number Generator (RNG): The specific cryptographic component determining jackpot outcomes. In this novel configuration, it accepts variable parameters (weights/thresholds) supplied by the JOAE.

Casino Backend System: Handles the financial reconciliation of personalized payouts and logs the specific “Odds Configurations” used for every win for regulatory auditing.

### Implementation Details:

The implementation of Loyalty-Based Dynamic Jackpot Odds Modification may require a distinct architectural departure from standard gaming networks. The Wager-Based Gaming System must implement the Jackpot Odds Adjustment Engine (JOAE) as a dedicated microservice.

Computational Architecture: The JOAE utilizes an adaptive algorithm to translate raw player metrics into a mathematical modifier. In at least one embodiment, the system defines a non-linear function, for example: Effective_Trigger_Threshold=Base_Threshold+(Base_Threshold*(Loyalty_Factor*0.5)+(Activity_Metric_Score*0.2)). Here, Loyalty Factor is a static integer assigned to tiers (e.g., Silver=1, Gold=2), and Activity_Metric_Score is a normalized float value derived from real-time session analytics (e.g., Current_Session_Wager/Average_Session_Wager). This calculation is performed per game cycle. This may require high-speed in-memory data grids (like Redis) to cache player profiles to ensure the retrieval and calculation add less than 50 ms to the game cycle, preventing lag.

Exclusive Pool Access Control: For VIP-Exclusive Jackpot Activation Windows (Inventive Concept 49), the system utilizes the Eligibility Tracker. This module implements a “Logic Lockout.” When an exclusive window opens (e.g., “Platinum Hour”), the Wager-Based Gaming System Core Module broadcasts a state change. However, the Eligibility Tracker intercepts this broadcast for every active session. It queries the player's token. If Player_Tier<Platinum, the tracker sends a “Lock” command to the specific jackpot UI elements on that player's EGM/ETGT or remote app, rendering the pool invisible or “Locked.” For qualifying players, it sends an “Unlock” command. This selective broadcasting may require a granular, session-based WebSocket architecture rather than simple UDP broadcasting used in older systems.

Hardware/Software Integration: Physical EGMs/ETGTs may require firmware capable of “Personalized UI Rendering.” The display software may be able to render a “Your Odds” meter or dynamic jackpot ticker that differs from the person sitting next to them. For remote players, the mobile app API must securely transmit the “Modified Odds” state to the client for display without exposing the actual RNG logic to the public internet.

Security: In at least one embodiment, the system employs a “Deterministic Replay” audit log. Because odds are dynamic, a simple “win/loss” log is insufficient for regulators. The system must log the Input_Metrics, the Calculated_Modifier, and the Final_RNG_Outcome for every trigger event to prove that the dynamic adjustment was applied consistently according to the certified algorithm and wasn't a glitch or manipulation.

### Example Walk-Through Scenario:

The scenario involves a “High-Roller Baccarat Tournament” evening. The casino configures the system to reward “Diamond” tier players.
1. Session Start: Remote Player A (Diamond Tier) logs into the Live Baccarat app from their hotel suite. Local Player B (Gold Tier) inserts their card into a physical ETGT at the same table.
2. Profile Ingestion: The Wager-Based Gaming System Core Module initiates sessions for both. It queries the Player Tracking Server.
3. Odds Calculation: The Jackpot Odds Adjustment Engine (JOAE) processes the data.
   Player A (Diamond): The algorithm calculates a modifier of 1.5× based on tier and a “High Frequency” boost because Player A played 4 hours yesterday.
   Player B (Gold): The algorithm calculates a modifier of 1.1×.
4. UI Update: Player A's mobile screen displays a glowing “1.5× Jackpot Odds Active” icon. Player B's ETGT screen shows “1.1× Odds Boost.”
5. Exclusive Window: At 9:00 PM, the “Diamond Jackpot” window opens.
   The Eligibility Tracker evaluates both sessions.
   Player A receives a “Diamond Pool Unlocked: $50,000” notification and the jackpot meter appears on their app.
   Player B sees a “Reach Diamond Tier to Unlock the $50,000 Pool” teaser message, but the pool remains locked.
6. Game Event: The dealer deals a “Player Pair.” This is a potential mystery trigger.
7. RNG Execution: The Core Module calls the RNG for both players to determine if the “Mystery” triggers.
   For Player A: The system uses a target range of 1-150 (Base 100*1.5). The RNG rolls 130. Result: Trigger.
   For Player B: The system uses a target range of 1-110. The RNG rolls 130. Result: No Trigger.
8. Outcome: Player A receives a “Jackpot Win” animation. The Dealer announces, “We have a Remote Diamond Winner!” The system credits Player A.

### Player Interaction:

Local Player: Upon card insertion, the ETGT screen transforms to a “Personalized Dashboard.” A progress bar may visualize their “Odds Boost” level. If they are in an “Exclusive Window,” the jackpot meter actively animates.

If they are ineligible, the meter may be greyed out with a tooltip explaining, “Play 50 more hands to unlock.” This provides clear, gamified feedback.

Remote Player: The mobile interface utilizes push notifications. “Your Diamond Status grants you 2× Odds for the next hour!” Tapping the notification deep-links them to the live table. During play, a dynamic “Luck Meter” overlay on the video feed represents their adjusted probability. If they win due to the boost, the celebration screen explicitly states, “Your Diamond Status helped you win this Jackpot!” reinforcing the value of the loyalty program.

### Distinguishing Innovative Elements:

The specific novelty is the technical operationalization of loyalty data into specific game mathematics. Prior art typically uses loyalty status for post-game rewards (comps, cash back) or separate bonus games. This Innovative Element injects the loyalty variables directly into the live execution path of the primary jackpot RNG. It changes the physics of the chance engine for that specific player.

Additionally, the concept of Synchronized Exclusion (Inventive Concept 49) is technically novel in a shared gaming environment. In traditional floor-wide progressives, everyone sees and chases the same number. In this Wager-Based Gaming System, two players betting on the same live event see fundamentally different prize potentials and probabilities. Enabling this “Multiverse” of jackpot states on a single physical table may require a sophisticated session-management layer (the Eligibility Tracker) that creates parallel game state views, a feature not present in conventional unified-state gaming machines.

### Distinguishing Inventive Steps:

1. Real-Time Metric Transcoding: The system executes a step where qualitative player data (e.g., “High Roller Status”) is transcoded into quantitative RNG parameters (e.g., Seed_Offset=0.004) via the JOAE. This transformation step ensures that abstract marketing concepts are converted into machine-executable logic instructions.
2. Session-Specific State Forking: The Wager-Based Gaming System Core Module executes a “forking” logic for broadcast messages. Instead of sending one “Jackpot Status” packet to all clients, it generates N distinct state packets for N active sessions, each customized with the recipient's specific odds and eligibility. This individualized broadcasting in a broadcast-heavy environment (live dealer) is a specific, non-obvious networking step.
3. Dynamic Probability Windowing: The system implements a sliding window for jackpot triggers that expands or contracts in real-time based on the Activity_Metric_Score (e.g., if a player speeds up betting, the window widens). This dynamic coupling of input speed to probability width is a novel procedural step.

### Technical Improvements to Existing Technical Problems:

1. Problem: Player Churn of High-Value Clients. High-value players often feel unrewarded by standard “fair” RNGs that treat them the same as casual players, leading to chum.
   Solution: Dynamic Odds Adjustment. The system technically alters the payout frequency for VIPs without manual intervention.
   Technical Advancement: This improves predictive algorithmic efficiency. By automating the retention mechanic (better odds), the system optimizes the “Return on Investment” of the prize pool, mathematically targeting the budget toward the players with the highest predicted LTV.
2. Problem: Static Jackpot Stagnation. Fixed jackpot rules may become stale. Changing them usually may require a server reset or regulatory downtime.
   Solution: Real-Time Parameter Injection. The JOAE allows odds and eligibility rules to be variables passed at runtime, not hardcoded constants.
   Technical Advancement: This improves system flexibility and uptime. It allows the casino to “hot-patch” the math model of the game (e.g., activating a VIP hour) without interrupting the game servers or rebooting terminals.
3. Problem: Computing Power for Personalization. Calculating unique odds for thousands of players every second is resource-intensive.
   Solution: Microservice Architecture (JOAE). Offloading the math to a dedicated engine that caches profiles.
   Technical Advancement: This improves computational resource management. It decouples the heavy statistical analysis from the latency-sensitive game state manager, ensuring that the complex personalization logic does not degrade the performance of the live video stream or wager processing.

### Data Input:

The system may require highly granular data inputs. Static Inputs include Player Tier (Bronze/Silver/Gold) and Account Age. Dynamic Historical Inputs include Average Daily Theoretical Loss (ADT), Visit Frequency, and Past Jackpot Wins. Real-Time Inputs are important: Current Session Duration, Average Bet in Last 10 Hands, and Rate of Play (Games per Hour). The Dealer may also provide input via the console (e.g., rating a player as “Friendly/Active”), which acts as a manual variable in the odds algorithm. These inputs are novel because they are typically used for marketing emails, not for real-time modification of the RNG execution path.

### Component Interactions and Procedural Steps:

1. Profile Query: When a session starts (Local or Remote), the Wager-Based Gaming System Core Module sends a GetProfile request to the Player Tracking Server.
2. Metric Feed: The Core Module begins streaming live play data (Bet=$50, Time=10:01:05) to the Jackpot Odds Adjustment Engine (JOAE) via an asynchronous message queue (e.g., Kafka).
3. Calculation: The JOAE runs the adaptive algorithm. It recalculates the Odds_Multiplier and Pool_Eligibility_Mask (a bitmask representing which pools are open).
4. State Push: The JOAE pushes the new Session_Parameters back to the Core Module.
5. Game Cycle Integration: When the dealer closes bets, the Core Module uses the specific Session_Parameters for each player to determine the Mystery Trigger result.
6. Result Distribution: If a win occurs based on modified odds, the Core Module sends a Win_Event tagged with the Modification_Reason (e.g., “VIP Boost”) to the Casino Backend System.
7. UI Sync: The Core Module sends a UI update command to the specific Physical EGM/ETGT or Remote Interface to display the “Boosted” status.

### Data Processing:

The Jackpot Odds Adjustment Engine performs continuous floating-point calculations. It normalizes diverse metrics (e.g., time in seconds, money in dollars) into a unified “Score.” It then maps this score to a probability curve. For example, a logistic function may be used to ensure that odds improve with activity but cap at a maximum limit to maintain house edge. The Eligibility Tracker performs boolean logic operations (AND/OR) against the complex rulesets of active campaigns (e.g., IF (Tier==Gold OR Bet>$100) AND (Time==20:00-22:00) THEN Unlock_Pool_B).

### Outputs and Responses:

The system generates personalized visual outputs: a Probability Meter on the player screen that fills up as they play, or a Locked/Unlocked Padlock icon on specific jackpot banners. The system sends Toast Notifications to remote mobile apps: “You've unlocked Platinum Odds!” It sends Audit Records to the Casino Backend, detailing exactly why a player won (e.g., “Win triggered at Roll 98; Base Threshold 95; Boosted Threshold 99”).

### Data Storage and Reporting:

Data storage involves high-volume TimeSeries Databases to store the fluctuating odds modifiers for every hand played. This is desirable for Regulatory Compliance-if a player questions why they didn't win, the casino may be able to replay the state and show the odds at that exact millisecond. Reporting dashboards visualize the “Lift”, showing the correlation between Odds Boosts and increased Wager Volume for VIP segments.

### Error Handling and Security Measures:

The system must handle State Desynchronization. If the JOAE lags and doesn't return a modifier in time for the game cycle, the Core Module defaults to Base_Odds (1.0×) to ensure the game proceeds without delay, and logs a “Fallback Warning.” Security Measures include Rate Limiting on the odds adjustment to prevent a hacked client from sending fake “High Activity” signals. The mathematical model used by the JOAE is “black-boxed” and encrypted; even the casino floor staff cannot see the exact formula, only the resulting tier, preventing insider manipulation.

### End of Interaction:

When the player leaves the table or logs out, the Wager-Based Gaming System Core Module sends a Session End signal. The JOAE performs a final calculation to update the player's historical metrics in the Player Tracking Server (e.g., adding the session's play time to the running total). The Odds Multiplier is reset to neutral. The Physical EGM/ETGT clears the personalized display and reverts to the “Attract Mode” or default interface for the next player.

### Innovative Element 4—Dynamic Jackpot Pooling and Sharing Based on Player Metrics and Physical Proximity

This Innovative Element defines a comprehensive funding and distribution subsystem within the Wager-Based Gaming System that dynamically alters the physics of the jackpot pool based on real-time environmental and behavioral metrics. Its specific purpose is to address two fundamental challenges in electronic gaming: the stagnation of jackpot growth during periods of low liquidity (low player count) and the social isolation inherent in individual terminal play. This element introduces Dynamic Jackpot Pooling, where the rate of jackpot accumulation is algorithmically accelerated or decelerated based on the real-time volume of active players (concurrency), and Mystery Jackpot Pool Sharing Between Adjacent Players (Neighbor Luck Share), which utilizes physical sensor data to distribute rewards to players spatially located next to a winner. This creates a practical application by transforming the jackpot from a static financial bucket into a responsive, living ecosystem that reacts to the energy of the casino floor. The computer is integral to this invention because it may require high-frequency monitoring of network-wide player states to execute non-linear contribution formulas and the processing of complex sensor data (RFID/Bluetooth) to spatially map player positions relative to a winning terminal in real-time.

Within the Wager-Based Gaming System, which integrates local and remote play, this element is implemented via a “Wager Contribution System” and a “Physical Proximity Tracking System.” The system enables a scenario where a sudden influx of remote players logging in via mobile devices triggers a “Jackpot Frenzy” mode, accelerating the visible growth of the jackpot meter on physical ETGTs to incentivize play. Simultaneously, it allows a local player's win on a physical machine to trigger a “Neighbor Bonus” for the person sitting next to them, identified via sensor triangulation, fostering a communal atmosphere. This contributes to the Wager-Based Gaming System's goals by optimizing the economic balance of the game (maintaining excitement during low and high traffic) and bridging the social gap between isolated electronic play and communal table games.

### Sequence Diagram Components:

Local Player: A player seated at a physical ETGT, participating in the wagering pool and subject to physical proximity tracking.

Remote Player: A player connected via web/mobile. They contribute to the “Active Player Count” metric that drives dynamic pooling and may participate in “Virtual Neighborhoods” for sharing purposes.

Physical EGM/ETGT: The gaming terminal equipped with proximity sensors (BLE/RFID) and a dynamic display that visualizes the current “Growth Rate” of the jackpot.

Wager-Based Gaming System Core Module: The central processing unit that aggregates wager data, executes the Dynamic Acceleration Algorithm, and manages the distribution logic.

Physical Proximity Tracking System: A specialized hardware/software subsystem responsible for detecting and verifying the physical presence and location of players relative to specific terminals.

Wager Contribution System: A logic module that calculates the specific fraction of each bet allocated to the jackpot based on the current acceleration factor.

Player Activity Tracker: A monitoring service that maintains a real-time count of “Active Players” (both local and remote) to feed the acceleration algorithm.

Casino Backend System: Handles the financial reconciliation of split payouts and stores the audit trails for variable contribution rates.

### Implementation Details:

In at least one embodiment, to implement the Physical Proximity Tracking System, each Physical EGM/ETGT is retrofitted with a Bluetooth Low Energy (BLE) Beacon array and a short-range NFC/RFID Reader at the player seat. When a Local Player sits down, they either insert a loyalty card (RFID) or their mobile device (running the casino app) detects the ETGT's BLE beacon. The system uses Signal Processing Logic based on RSSI (Received Signal Strength Indicator) values. The logic defines a “Proximity Threshold” (e.g., RSSI>-40 dBm) to confirm immediate presence. To verify “Adjacency” (Neighbor Luck Share), the system utilizes a topological map stored in the Core Module. When Terminal A wins, the system queries the map for Neighbor Terminals B and C. It then polls the sensors on Terminals B and C. If valid player sessions are active and verified by the sensor presence check within the last 30 seconds, they are flagged as eligible neighbors. This prevents “ghost” payouts to empty seats.

To implement Dynamic Jackpot Pooling, the Wager Contribution System employs a Dynamic Acceleration Algorithm. Unlike standard progressives that take a fixed percentage (e.g., 1.0%) of every bet, this system uses a non-linear response curve. The algorithm is defined as: Contribution_Rate=Base_Rate*(1+log(Active_Player_Count)). This formula ensures that as player concurrency grows, the jackpot grows exponentially faster, creating a visual “frenzy” effect on the meters. To prevent network instability or unfair allocation, the system implements Tiered Response Thresholds. For example, the rate updates only change when player counts cross specific tiers (e.g., 50, 100, 500 players) rather than oscillating wildly with every single login/logout. This creates stable but responsive “Heat Levels” (e.g., “Jackpot is Heating Up!”, “Jackpot is Boiling!”).

For the combined Wager-Based Gaming System, Remote Players contribute to the Active Player_Count, meaning a remote audience directly benefits local players by driving up the jackpot value. Remote players are assigned “Virtual Neighbors” based on login time or a “Lobby” metaphor, allowing the Neighbor Luck Share logic to extend digitally.

### Example Walk-Through Scenario:

It is a busy Friday night. The Player Activity Tracker registers 450 concurrent users (150 local on the floor, 300 remote). The Wager Contribution System evaluates this count against the Dynamic Acceleration Algorithm. It determines that the system is in “Tier 3 Acceleration.”
1. State Update: The Core Module broadcasts a message to all 450 endpoints. The jackpot meters on physical ETGTs and mobile phones begin glowing red, and the text “3× Growth Rate Active!” pulses on the screens.
2. Gameplay: Local Player A at ETGT #12 places a $10 bet. Instead of the standard $0.10 contribution, the system allocates $0.30 to the pool due to the multiplier, causing the visible meter to tick up rapidly.
3. Trigger Event: Local Player A hits the Mystery Jackpot trigger condition.
4. Proximity Check: The Core Module initiates the Neighbor Luck Share protocol. It identifies ETGT #11 and ETGT #13 as physical neighbors.
5. Sensor Validation: The Physical Proximity Tracking System polls the RFID readers on #11 and #13. It confirms that Player B is logged into #11. However, #13 reports “Idle/No Card.”
6. Distribution: The system awards the Primary Jackpot ($10,000) to Player A. It calculates a Neighbor Share ($500). Player B at #11 receives a notification: “Neighbor Bonus! Player A won the Jackpot, so you win $500!” ETGT #13 receives nothing.
7. Remote Share: The system identifies Remote Player C, who “sat” at the virtual table next to Player A in the app interface. Player C also receives a $500 Virtual Neighbor bonus.

### Player Interaction:

Local Player: The user interface on the physical ETGT includes a “Community Meter.” This graphical element displays the current “Heat Level” of the casino (based on active players). As more people play, the meter fills, and the graphical fire effects around the jackpot digits intensify. If a player is seated next to a winner, their screen is interrupted by a “Neighbor Win!” celebration animation, distinct from a primary win, clearly indicating the source of the funds (“Won by Seat 12—Shared with You!”).

Remote Player: The mobile interface features a “Lobby Map” showing which physical or virtual table they are joined to. They see the same “Heat Level” indicators. When a Neighbor Share occurs, their device vibrates, and a push notification appears. They may send “Congratulations” emojis that appear on the physical screen of the winner (Player A), bridging the remote-local divide.

### Distinguishing Innovative Elements:

The specific novelty is the technical coupling of macroeconomic game states (total active players) with microeconomic game mechanics (individual contribution rates). Prior art typically treats jackpot contribution rates as immutable constants hard-coded into the machine's ROM (Read-Only Memory) or fixed in server settings. This Innovative Element treats the contribution rate as a dynamic variable controlled by a real-time feedback loop from the Player Activity Tracker. This creates a self-regulating economy where the jackpot becomes more attractive exactly when the casino is busiest, or conversely, may be “boosted” artificially during slow times to stimulate demand.

Additionally, the Sensor-Based Neighbor Verification distinguishes this from standard “Community Bonuses.” In prior art, community bonuses are often just “everyone active gets $5.” This invention uses spatial telemetry (BLE/RFID) to enforce a specific geometric relationship (adjacency) as a condition for payout. This may require the Wager-Based Gaming System to possess and process a “Physical Topology Map” of the casino floor, translating X,Y coordinates into payout logic, which is a non-obvious integration of facility management data with wagering logic.

### Distinguishing Inventive Steps:

1. Non-Linear Rate Scaling: The system executes a continuous mathematical transformation of the Active_Player_Count integer into a Contribution_Multiplier float using a logarithmic or exponential curve. This specific algorithmic step stabilizes the jackpot economy, preventing runaway growth while ensuring visible acceleration.
2. Spatial-Temporal Validation: The system executes a multi-factor validation step for Neighbor Bonuses. It does not just check “Is the machine active?”; it checks “Is a human verified to be physically present at the specific adjacent coordinates at the exact timestamp of the win?” utilizing the sensor data. This prevents “machine camping” (one person playing multiple adjacent machines to capture neighbor bonuses) by requiring unique biometric or ID tokens at each seat.
3. Hybrid Topology Mapping: The system maps Remote Players into the physical topology. It executes a “Virtual Seat Assignment” step, placing remote players into logical slots adjacent to physical players or other remote players, enabling the “Neighbor” logic to function in a hybrid physical/digital space.

### Technical Improvements to Existing Technical Problems:

1. Problem: “Cold” Jackpots reducing play. During off-peak hours, progressive jackpots move so slowly that players perceive the game as “dead” or “tight,” leading to disengagement.
   Solution: Dynamic Acceleration. Even with fewer players, the system may adjust the curves to maintain a visible “tick rate” on the meter, or conversely, use the high volume of remote players to drive the visual growth of the physical jackpot signs, making the floor look active.
   Technical Advancement: This improves utilization of gaming assets. By virtually pooling liquidity from remote players to animate physical signage, the system solves the “empty floor” problem.
2. Problem: Fraud in Community Payouts. In standard systems, players may try to claim community bonuses by quickly betting on empty machines when a jackpot seems imminent.
   Solution: Sensor-Based Presence Verification. The requirement for verified RF/BLE presence prevents “ghost playing.”
   Technical Advancement: This improves transactional integrity. The system adds a physical layer of authentication (proximity token) to the logical layer of the wager.
3. Problem: Network Instability from Rapid Updates. If every single player login triggered a database write to change the global jackpot contribution rate, the system would suffer from “thrashing.”
   Solution: Tiered Response Thresholds. The algorithm dampens the input data, only triggering state changes at significant intervals.
   Technical Advancement: This improves system stability and load management. It functions as a digital hysteresis loop, filtering out noise (rapid logins/logouts) to maintain a stable game state.

### Data Input:

The system ingests unique data streams: Telemetry Data (RSSI signal strength, Beacon UUIDs) from the physical floor, Concurrency Metrics (Integer count of active WebSocket connections) from the remote servers, and Topology Configuration (XML/JSON map of machine physical layouts). The Sensor Data is particularly novel as a direct input for financial distribution logic in a slot/table system.

### Component Interactions and Procedural Steps:

1. Concurrency Monitor: The Player Activity Tracker polls the session registry every 5 seconds. It returns an aggregate count.
2. Rate Adjustment: The Wager Contribution System inputs this count into the Acceleration Algorithm. If a tier is crossed, it updates the Global_Contribution_Rate.
3. Wager Processing: When a player bets, the Core Module reads the current Global_Contribution_Rate to split the money (Game vs. Jackpot).
4. Trigger Event: A jackpot is won. The Core Module queries the Physical Proximity Tracking System.
5. Proximity Scan: The Tracking System reads the RSSI values from the winner's neighbors. It filters signals below −40 dBm. It returns a list of Verified Neighbor_IDs.
6. Distribution: The Core Module executes the payout transactions for the Winner and the Verified_Neighbor_IDs.
7. Notification: The Video Streaming Server and ETGT displays perform a coordinated “Pulse” animation to visualize the payout spreading from the winner to the neighbors.

### Data Processing:

Processing involves Signal Triangulation (converting raw signal strength into distance estimates), Trend Analysis (calculating the rate of change of player concurrency to predict “Heat Levels”), and Financial Splitting (dividing a single wager into variable buckets based on the dynamic rate). The Dynamic Acceleration Algorithm may be deterministic and auditable, meaning the system may be able to reconstruct why the rate was 1.5% at 10:00 PM based on the logged player counts.

### Outputs and Responses:

Outputs include Visual Heat Maps on casino signage (showing active zones), Haptic Feedback on mobile devices (vibrating when the “Heat Level” rises), and Financial Credits. The system sends Configuration Updates to the ETGT firmware to change the speed of the LED meter ticking, providing immediate visual feedback of the accelerated state.

### Data Storage and Reporting:

The system stores TimeSeries Data for player concurrency and contribution rates. This allows analysts to optimize the acceleration curves. It also stores Proximity Logs (Who sat next to whom and when), which is valuable for social network analysis and detecting collusion rings.

### Error Handling and Security Measures:

Error Handling: If the proximity sensors fail, the system falls back to a “Logical Adjacency” (based on machine ID numbers) but flags the transaction for review. Security: To prevent Signal Spoofing (using a high-gain antenna to appear “adjacent” from a distance), the system cross-references the RSSI data with the player's bet activity. If a signal is strong but no buttons are being pressed, the presence is marked as “Suspicious.” The Acceleration Algorithm includes Cap Limits (e.g., max 5% contribution) to prevent a software bug or botnet attack from draining player balances too fast into the jackpot.

### End of Interaction:

The cycle ends when the player cashes out. The Physical Proximity Tracking System detects the loss of the BLE/RFID signal and marks the seat as “Vacant” after a debounce period (e.g., 10 seconds). The Player Activity Tracker decrements the global count. If this crosses a threshold, the Wager Contribution System lowers the acceleration tier, and the “Heat Level” visual on all machines cools down, signaling the change in state to the floor.

### Multi-Game State Synchronization Algorithm

### Detailed Technical Description & Implementation Details:

In at least one embodiment relating to the synchronization of disparate game types (e.g., card games vs. wheel games) during a system-wide jackpot event, the Wager-Based Gaming System implements a specialized Multi-Game State Synchronization Algorithm within the Wager-Based Gaming System Core Module. This algorithm functions as a deterministic state machine orchestrator that manages the transition from independent game cycles to a unified “Jackpot Event State.”

The implementation relies on a “Safe State” Registry. Every connected Electronic Table Game Terminal (ETGT), whether physical or virtual (for remote players), is programmed to report its current status to the Core Module via a persistent WebSocket connection. The defined states include: STATE_IDLE, STATE_BETTING_OPEN, STATE_GAME_ACTIVE (locked), and STATE_RESOLVING.

The synchronization logic uses a Two-Phase Commit Lockout Mechanism:
1. Phase 1: The Prepare Signal: When a global jackpot event is triggered (e.g., by a Dealer-Initiated Trigger or a Random Timer), the Core Module broadcasts a PREPARE_JACKPOT_LOCK signal to all terminals.
2. Phase 2: Asynchronous State Resolution:
   Terminals in STATE_IDLE or STATE_BETTING_OPEN immediately transition to STATE_JACKPOT_PENDING, locking user inputs and displaying a “Jackpot Incoming” overlay.
   Terminals in STATE_GAME_ACTIVE (e.g., cards are being dealt, roulette wheel is spinning) do not interrupt the active game round to preserve regulatory compliance and game integrity. Instead, they set a local flag LOCK_ON_COMPLETION=True.
   Once the active game round concludes and the terminal transitions to STATE_RESOLVING (payouts), the local software checks the flag and immediately transitions to STATE_JACKPOT_PENDING instead of opening betting for the next round.
3. Phase 3: Synchronous Execution: The Core Module maintains a “Ready Map” of all connected clients. Only when all targeted clients report STATE_JACKPOT_PENDING (or a timeout threshold of 5.0 seconds is reached, excluding lagging clients from the visual event but processing them logically) does the Core Module broadcast the EXECUTE_JACKPOT command.

### Pseudo-Code Logic for WAP Server:

Code snippet

```
  Function TriggerGlobalJackpot( ):
TargetTerminals = GetAllActiveSessions( )
ReadyCount = 0
    For Each Terminal in TargetTerminals:
    SendSignal(Terminal.ID, “PREPARE_LOCK”)
    StartTimer(Timeout = 5000ms)
    While ReadyCount < Count(TargetTerminals) AND Timer > 0:
    IncomingMessage = ListenForUpdates( )
    If IncomingMessage.Type == “STATE_READY”:
      ReadyCount++
    // Execution Phase
JackpotResult = RNG_GenerateOutcome( )
Broadcast(TargetTerminals, “EXECUTE_ANIMATION”, JackpotResult)
    // Cleanup
Wait(AnimationDuration)
Broadcast(TargetTerminals, “RELEASE_LOCK”)
```

This implementation ensures that a Roulette game (long cycle) and a Baccarat game (short cycle) may participate in the same simultaneous jackpot event without disrupting the fairness of the base game.

### Practical Application:

The practical application of this algorithm lies in the operational capability to link heterogeneous gaming devices into a single, cohesive progressive network. In a real-world casino floor utilizing the Wager-Based Gaming System, live dealers operate tables with vastly different paces. Without this specific synchronization logic, a “Dealer-Initiated Jackpot” would be impossible to implement fairly, a blackjack player may see the jackpot animation while still deciding to “Hit” or “Stand,” creating confusion and potential regulatory disputes regarding game interference.

The computer is integral to this invention because the coordination may require sub-second processing of state messages from hundreds of concurrent sessions-both local physical terminals and remote mobile devices. A human operator cannot manually synchronize the start of a jackpot event across 50 different devices that are all in different phases of gameplay. The algorithmic control of the “Lockout” mechanism ensures that the digital overlay of the jackpot respects the inviolable logic of the physical base game, an important requirement for regulatory approval.

### Technological Improvement/Improved Computer Functioning:

The Multi-Game State Synchronization Algorithm improves the technological process of networked gaming by solving the concurrency conflict problem. In prior art systems, jackpots are often siloed by game type because synchronizing unlike games is technologically difficult. This invention improves computer functioning by introducing a state-aware interrupt handler at the network level.

By utilizing the “Safe State” Registry and the Two-Phase Commit logic, the system reduces network congestion and processing errors associated with “race conditions” where a jackpot trigger may conflict with a game result packet. This improves data integrity. Furthermore, the implementation of a “Timeout Fallback” (processing lagging clients logically rather than visually) improves system resilience, preventing a single player with a poor mobile connection from hanging the entire casino floor's jackpot system. This represents a specific optimization of distributed network architecture for the latency-sensitive environment of live-dealer gaming.

### Example Walk-Through Scenario:

The casino floor features a “Mega Mystery” link connecting Live Baccarat and Live Roulette. A remote player, “User A,” is playing Baccarat via smartphone (4G connection). A local player, “User B,” is at a physical Roulette ETGT.
1. Trigger Event: The Wide Area Progressive (WAP) server determines a random mystery jackpot is due.
2. State Assessment:
   User A (Baccarat): Is currently betting. The server sends the PREPARE_LOCK. The app immediately locks the betting chips, overlays a “Jackpot Pending” spinner, and sends STATE_READY.
   User B (Roulette): The ball is spinning (Active Game). The terminal receives PREPARE_LOCK. It does not interrupt the spin. The ball lands on “Red 7”. The terminal pays User B for the roulette win.
3. Synchronization: Immediately after the roulette payout, User B's terminal executes the lock. It sends STATE_READY to the server.
4. Execution: The Server sees both users are ready. It broadcasts the EXECUTE_JACKPOT command.
5. Unified Experience: Simultaneously, User A's phone and User B's physical screen explode with the same “Mega Mystery” animation. The server determines User A is the winner. User B sees “Winner: User A” on their main screen.
6. Resume: After 10 seconds, the server sends RELEASE_LOCK. User A is credited, and User B is presented with the betting screen for the next roulette spin.

### Detailed Architecture and Secure Communication Protocols for the Third-Party Sponsor System and Social Media Integration System

### Detailed Technical Description & Implementation Details:

In at least one embodiment relating to the secure integration of external, non-wagering data sources into the regulated Wager-Based Gaming System, the architecture implements a strict “Defense-in-Depth” network topology utilizing a Sandboxed Verification Module (SVM) located within a Demilitarized Zone (DMZ). This architecture is designed to facilitate the ingestion of Third-Party Sponsor funds and Social Media interaction data while maintaining the cryptographic integrity of the casino's internal Game Logic LAN.

### 1. Third-Party Sponsor System Architecture:

The integration with external sponsors (e.g., luxury brands, financial institutions) relies on a Secure API Gateway acting as the ingress point. This gateway enforces Mutual Transport Layer Security (mTLS). Unlike standard SSL where only the server proves its identity, mTLS may require the Third-Party Sponsor System to present a client certificate signed by the Casino's Certificate Authority (CA). This ensures that only authorized endpoints may initiate a connection.

The communication protocol for funding transfers utilizes a Two-Phase Commit (2PC) logic over secure RESTful APIs or ISO 8583 financial messaging standards.
Phase 1 (Reservation): The Sponsor System sends a signed payload containing Campaign_ID, Fund_Amount, and Media_Asset_URL. The SVM validates the signature and verifies the funds with the external Payment Gateway.
Phase 2 (Commit): Upon successful validation, the SVM generates an internal, sanitized Credit_Injection_Token. This token is passed through a unidirectional firewall to the Casino Backend System. The Backend System then “unlocks” the promotional content on the Electronic Table Game Terminals (ETGTs). This separation ensures that raw external data packets never directly reach the Wager-Based Gaming System Core Module.

### 2. Social Media Integration System Architecture:

The integration with platforms like Facebook, WeChat, or Instagram utilizes Webhook Listeners hosted on the SVM. Since social platforms operate on the public internet, this interface is vulnerable to spoofing. The system implements a Hash-Based Message Authentication Code (HMAC) verification strategy.
Secret Exchange: During setup, the Casino and the Social Platform exchange a cryptographically secure App_Secret.
Payload Signing: When a Remote Player performs a social action (e.g., “Share”), the Social Platform hashes the payload body using the App_Secret and the SHA-256 algorithm. This hash is included in the HTTP header (e.g., X-Hub-Signature-256).
Verification: The SVM receives the payload. Instead of parsing the JSON immediately, it independently computes the hash of the incoming raw body using its stored App_Secret. It performs a constant-time string comparison between the calculated hash and the header hash. Only if they match perfectly does the system proceed to parse the Player_ID and Action_Type.
Internal Signaling: Once verified, the SVM maps the external Social_User_ID to the internal Casino_Account_ID using a secure lookup table. It then generates an internal gRPC message Grant Eligibility(Player_ID, Bonus_Type) which is sent to the Wager-Based Gaming System Core Module to adjust the RNG parameters or unlock jackpot tiers.

### 3. Sandboxed Verification Module (SVM):

The SVM is a hardened containerized service (e.g., Docker/Kubemetes) with stripped-down privileges. It has no direct database access to the specific gaming tables. It communicates with the internal network solely via a message queue (e.g., RabbitMQ or Kafka) configured for unidirectional flow where possible. This ensures that even if the SVM is compromised via a malformed external packet, the attacker cannot pivot to the Wager-Based Gaming System Core Module or manipulate the RNG seeds directly.

### Practical Application:

The practical application of this secure architecture is the enabling of “Sponsored Jackpots” and “Social-to-Earn” mechanics within a regulated gambling environment. In a real-world scenario, a Macau casino may host a “Golden Week” event sponsored by a luxury watchmaker. The watchmaker's system may programmatically inject $50,000 into the jackpot pool at 8:00 PM. The architecture described above ensures that this external financial injection triggers the display of the watchmaker's advertisement on the physical ETGTs simultaneously, creating a synchronized commercial event.

Without this specific computer architecture, the casino would be unable to automate this process due to regulatory risks. A manual process would be too slow to synchronize the funds with the ads in real-time. Similarly, for social media, the practical application allows a player on the casino floor to scan a QR code, share a win on WeChat, and instantly see their jackpot odds improve on the physical machine in front of them. The computer is integral because the speed of verification (hashing and cross-referencing IDs) must happen in milliseconds to maintain the flow of the live game. A human cannot cryptographically verify a webhook signature or facilitate a sub-second financial handshake between a brand's bank and a casino's ledger to trigger a game state change.

### Technological Improvement/Improved Computer Functioning:

This subject matter improves the technological process of secure data ingestion in important systems. Conventional gaming systems operate on “Air Gapped” or strictly isolated networks to prevent tampering. This creates a technical problem: they cannot easily interact with the dynamic, connected world of digital marketing and external finance.

The implementation of the Sandboxed Verification Module (SVM) with HMAC Verification and Unidirectional Message Queuing provides a specific technical solution. It improves computer functioning by offloading the CPU-intensive task of cryptographic verification and JSON parsing (which is prone to parsing attacks) to a disposable edge component (the SVM). This protects the Wager-Based Gaming System Core Module, allowing it to dedicate its resources to low-latency game state management and RNG processing.

Furthermore, this architecture solves the “Oracle Problem” in gaming (bringing real-world data onto the blockchain or secure ledger). By treating the Social Media API responses as untrusted data that may be “sanitized” and “re-packaged” into internal gRPC formats before crossing the network boundary, the system improves data integrity. It prevents “Replay Attacks” (where a user tries to resend the same “Share” success message to get multiple bonuses) by implementing nonces and timestamp checks within the SVM before the data ever reaches the wagering engine.

### Example Walk-Through Scenario:

### Scenario: The “Red Dragon” Social Bonus Event

1. Initiation: A Remote Player playing Live Baccarat on their smartphone sees a prompt: “Share your win to unlock the Red Dragon Jackpot Tier.” The player clicks “Share.”
2. External Transmission: The player's device communicates with the Social Media Platform API. The platform confirms the share and fires a webhook event to the Casino's registered endpoint URL.
3. Ingestion (The Gateway): The Secure API Gateway receives the POST request. It checks the IP whitelist and rate limits. If valid, it passes the encrypted packet to the Sandboxed Verification Module (SVM).
4. Verification (The Sandbox):
   The SVM extracts the X-Hub-Signature-256 header.
   It retrieves the stored App_Secret from a Hardware Security Module (HSM).
   It runs the SHA-256 hash function on the payload body.
   It compares the result. Match Confirmed.
   The SVM checks the payload timestamp. It is within the 5-second acceptance window (preventing replay attacks).
5. Transformation: The SVM extracts the Social_User_ID. It queries a localized mapping table to find the corresponding Casino Player ID.
6. Internal Injection: The SVM constructs an internal message: Type: ELIGIBILITY_UPDATE, Target: Player_12345, Value: UNLOCK_TIER RED. It pushes this message to the internal Message Queue.
7. Execution: The Wager-Based Gaming System Core Module consumes the message from the queue. It updates the active session for Player 12345.
8. Result: On the player's screen (and on the physical ETGT if they were playing locally), the “Red Dragon Jackpot” icon unlocks and begins glowing. The entire process from “Click” to “Unlock” took 200 milliseconds, providing instant gratification without exposing the game server to the public internet.

### Technical Description of the Jackpot Odds Adjustment Engine

### Detailed Technical Description & Implementation Details:

In at least one embodiment relating to the specific algorithmic operation of the Jackpot Odds Adjustment Engine (JOAE), the Wager-Based Gaming System implements a specialized computational kernel resident within the First Server System (Wager-Based Gaming System Core Module). This engine is responsible for the real-time ingestion of player telemetry and the deterministic execution of an Adaptive Probability Algorithm.

### 1. Data Ingestion Layer:

The JOAE operates on a “Sliding Window” basis, ingesting a stream of Player Activity Metrics ($M$) over a defined timeframe $t$ (e.g., the last 30 minutes). The specific metrics tracked and normalized include:
Velocity (SVS): Wagers per minute.
Volume (SVolS): Total currency wagered in $t$.
Retention (SRS): Consecutive active days.
Tier (STS): A static multiplier based on VIP status (e.g., Bronze=1.0, Silver=1.1, Gold=1.2).

### 2. The Adaptive Algorithm (Mathematical Function):

The specific innovation is the transformation of these raw metrics into a single scalar value, the Personalized Probability Modifier ($PPM$). The system employs a weighted non-linear function to prevent exploitation while rewarding sustained engagement.

The formula is implemented as follows:

$$\$\$PPM = T ∖ times ( 1 + ∖ tanh ( ∖ alpha ∖ cdot V + ∖ beta ∖ cdot Vol + ∖ gamma ∖ cdot R ) ) \$\$$$

Where $\alpha$, $\beta$, and $\gamma$ are weighting coefficients configured by casino management to prioritize certain behaviors (e.g., valuing speed over volume). The hyperbolic tangent function ($\tanh$) is used to dampen the inputs, ensuring the $PPM$ scales smoothly and approaches a maximum cap (e.g., 2.0× odds) without growing infinitely, preserving the casino's mathematical house edge.

### 3. RNG Seed/Range Modification:

Conventional RNGs compare a generated number against a static Target_Value. The JOAE alters this comparison logic at the moment of the trigger request.

$$Standard Logic : IF Random ( 1 , 1 , 000 , 000 ) < = Base\_Target ( e . g . , 50 ) THEN Win .$$

$$Modified Logic : IF Random ( 1 , 1 , 000 , 000 ) < = Base\_Target * PPM ) THEN Win .$$

If Player A has a $PPM$ of 1.5 calculated by the engine, their effective target becomes 75 instead of 50, statistically improving their win rate by 50% for that specific microsecond. This calculation is performed atomically for every single game round initiated by the player, ensuring the odds are constantly “breathing” and reacting to the live gameplay speed and intensity.

### Practical Application:

The practical application of the Jackpot Odds Adjustment Engine is the creation of a “Responsive Luck” environment within a regulated casino network. In a standard casino, a player's experience with luck is entirely random and indifferent to their loyalty. This invention applies computer processing to create a feedback loop where the machine appears to “recognize” effort.

For example, in a Live Dealer ETG setup, a high-value player may feel “cold” and consider leaving. The JOAE detects the drop in Velocity but high Volume. It may temporarily adjust the weights to boost the $PPM$, increasing the frequency of “Mystery Bonus” triggers to retain the player. The computer is not merely a tool for generating numbers; it is an integral component that acts as a real-time actuary, assessing the value of the player to the casino and instantaneously adjusting the “price” (odds) of the jackpot to maximize Player Lifetime Value (LTV) while maintaining regulatory compliance through deterministic, auditable algorithms.

### Technological Improvement/Improved Computer Functioning:

This subject matter improves the technological process of Random Number Generation and Probability Management in gaming systems. Prior art systems typically use static probability tables loaded into memory at boot time. Changing odds usually may require a firmware update or a server restart, which is operationally inefficient.

The JOAE improves computer functioning by introducing a Dynamic Parameter Injection architecture. It decouples the “Rules of Probability” from the “Execution of Probability.” By separating the logic into a high-speed calculation engine (JOAE) and an execution engine (RNG Core), the system allows for granular, per-session, per-transaction modification of the gaming math without interrupting the game state. This represents a specific technical optimization for high-concurrency transaction processing where the parameters of the transaction (the odds) are fluid rather than fixed. Furthermore, the use of the $\tanh$ dampening function provides a specific technical solution to the problem of “bonus runaway” or economic instability in algorithmic reward systems, ensuring the system remains mathematically solvent even under extreme player behavior.

### Example Walk-Through Scenario:

Scenario: Two players, Player A (VIP) and Player B (Casual), are playing Electronic Roulette at the same physical table.
1. Baseline: The Mystery Jackpot has a base trigger chance of 1 in 1,000.
2. Input:
   Player A is betting $500/spin every 20 seconds. Tier: Gold (1.2×).
   Player B is betting $10/spin every 60 seconds. Tier: Bronze (1.0×).
3. Processing (JOAE):
   The Engine calculates Player A's metrics. High Volume and Velocity drive the inner formula sum to 0.8. $\tanh(0.8) \approx 0.66$.

$$\$PPM\_A = 1.2 ∖ times ( 1 + 0.66 ) = 1 \text{.99} \$ .$$

The Engine calculates Player B's metrics. Low inputs drive the sum to 0.1. $\tanh(0.1) \approx 0.1$.

$$\$PPM\_B = 1. ∖ times ( 1 + 0.1 ) = 1.1 \$ .$$

4. Execution: Both players finish a spin. The Core Module requests a jackpot check.
5. RNG Check:
   For Player A, the system checks if Random(1000)<=1.99. (Roughly 1 in 500 chance).
   For Player B, the system checks if Random(1000)<=1.1. (Roughly 1 in 909 chance).
6. Result: Player A has nearly double the statistical likelihood of triggering the event compared to Player B, purely based on the algorithmic processing of their real-time behavior.

### Detailed Technical Description of the Physical Proximity Tracking System

### Detailed Technical Description & Implementation Details:

In at least one embodiment relating to the specific hardware and signal processing logic required to implement the “Neighbor Luck Share” (Inventive Concept 43), the Wager-Based Gaming System integrates a Physical Proximity Tracking System (PPTS). This subsystem is designed to deterministically map the physical relationships between players and terminals in real-time, converting spatial data into financial eligibility logic.

### 1. Sensor Hardware Architecture:

The implementation utilizes a Multi-Modal Sensor Fusion approach to ensure accuracy and prevent fraud (e.g., “signal spoofing” where a player claims to be adjacent from a distance).
NFC/RFID Transceivers: Each Physical Electronic Table Game Terminal (ETGT) is equipped with a short-range (ISO 14443) Near Field Communication (NFC) reader embedded directly into the player armrest or player tracking unit. This may require the physical presence of a loyalty card or an NFC-enabled smartphone within 4 centimeters of the sensor, serving as the primary “Proof of Presence.”
Bluetooth Low Energy (BLE) Beacon Array: To support players using the casino mobile app without physical cards, the casino floor is gridded with BLE Beacons. Each ETGT emits a unique UUID. The player's mobile device calculates the Received Signal Strength Indicator (RSSI) relative to surrounding beacons.
Topology Map: The Wager-Based Gaming System Core Module stores a static Geo-Spatial Configuration Database (JSON/XML format) defining the physical coordinates $(x, y, z)$ of every terminal. It explicitly defines “Adjacency Pairs” (e.g., Terminal_101 is adjacent to Terminal_102 and Terminal_103).

### 2. Signal Processing Logic:

The PPTS executes a Proximity Validation Algorithm every game cycle.
RSSI Filtering: Raw Bluetooth signals fluctuate. The system uses a Kalman Filter to smooth the RSSI data stream, rejecting transient noise.
Thresholding: The logic defines a strict Proximity Threshold (e.g., $RSSI>-55\text{dBm}$). If the smoothed signal strength is below this threshold, the player is deemed “Not Seated.”
Session Binding: When a player logs in, the system creates a Session_Binding object linking Player_ID+Terminal_ID. This binding is validated against the sensor data. If the sensor data (RFID removal or BLE signal drop) disappears for more than a defined Debounce Interval (e.g., 30 seconds), the binding is broken, and the player loses “Neighbor” eligibility.

### 3. Dynamic State Handling:

The system handles real-time flux (players sitting down or leaving) using an Event-Driven State Machine.
Event: Player_Sit: Sensor detects ID. System queries Topology Map. System updates the Neighbor Graph in memory (e.g., Terminal_102.Right_Neighbor=Player_ID_55).
Event: Player Leave: Sensor signal lost. System starts Debounce_Timer. If timer expires, Terminal_102.Right_Neighbor=NULL.
   This logic ensures that a player who stands up to cheer at the exact moment a jackpot hits does not lose their payout due to a momentary sensor disconnect.

### Practical Application:

The practical application of the Physical Proximity Tracking System is the automation of “Community Gaming” mechanics in a modem, high-throughput casino environment. In traditional table games, a human dealer visually confirms who is sitting next to a winner and manually pays them. In an electronic environment with hundreds of terminals, manual verification is impossible. This invention applies computer technology to automate the spatial verification process with sub-second latency.

The computer is integral to this invention because the “Neighbor Luck Share” relies on the instantaneous synthesis of three distinct data sets: (1) the random jackpot trigger event, (2) the static physical layout of the casino floor, and (3) the dynamic, real-time location data of hundreds of mobile players. A human cannot continuously calculate RSSI signal strength vectors or query a database of adjacency pairs in the millisecond between a jackpot trigger and the display of the “You Won!” animation. The PPTS provides the hardware-software bridge that allows the Wager-Based Gaming System to treat “Physical Proximity” as a programmable variable in the payout equation, transforming the abstract concept of “sitting together” into a concrete, executable financial transaction.

### Technological Improvement/Improved Computer Functioning:

This subject matter improves the technological process of Location-Based Services (LBS) in Wagering Systems. Prior art often relies on “Logical Adjacency” (e.g., Terminal IDs 001 and 002 are sequential), which fails if the physical machines are moved or if a player is playing remotely.

The implementation of the PPTS improves computer functioning through Spatial Data Indexing and Sensor Fusion.
1. Improved Data Integrity: By requiring multi-factor authentication for location (e.g., verifying the Logical Login via the App and the Physical Presence via BLE/RFID), the system drastically reduces the error rate of payouts. It solves the technical problem of “Ghost Sessions” where a card is left in a machine but the player is gone. The Debounce_Timer logic improves system stability by preventing “flickering” eligibility caused by signal interference.
2. Computational Optimization: Instead of calculating distance vectors for every player every second (which is computationally expensive), the system utilizes the pre-computed Topology Map. The runtime logic only needs to check the status of the pre-linked “Neighbor Nodes” in the database graph. This reduces the complexity of the lookup from $O(N)$ to $O(1)$ during the important jackpot trigger phase, ensuring the system scales to thousands of terminals without lag.
3. Dynamic Reconfiguration: The system allows for logical remapping. If the casino rearranges the floor, updating the JSON Topology Map instantly updates the payout logic without requiring firmware updates on the individual machines.

### Example Walk-Through Scenario:

Scenario: A “Neighbor Luck Share” event on a bank of Electronic Roulette terminals.
1. Setup: Three terminals are arranged in a row: Terminal A (Left), Terminal B (Center), Terminal C (Right).
2. Player Status:
   Player 1 is seated at Terminal A, using a physical loyalty card (RFID detected).
   Player 2 is seated at Terminal B, using the mobile app (BLE signal strength−45 dBm, verified).
   Terminal C is currently empty (No RFID, No associated BLE session).
3. Trigger Event: Player 2 at Terminal B hits a specific “Zero Spin” that triggers the Mystery Jackpot.
4. Adjacency Lookup:
   The Wager-Based Gaming System Core Module receives the trigger from Terminal B.
   It queries the Topology Map for Terminal B's neighbors. Result: {Left: Terminal_A, Right: Terminal_C}.
5. Sensor Verification:
   The system polls the PPTS for the status of Terminal A. The PPTS confirms: “Active Session, RFID Verified, Last Interaction <5 seconds ago.” Result: Eligible.
   The system polls Terminal C. The PPTS reports: “Idle State, No Sensors Active.” Result: Ineligible.
6. Execution:
   Player 2 (Center) receives the Primary Jackpot ($5,000).
   Player 1 (Left) receives the Neighbor Share ($500).
   The system logs the spatial data: “Win Origin: Term_B; Neighbor_Left: Term_A (Paid); Neighbor_Right: Term_C (Void).”
7. Display: Terminal A's screen flashes: “Neighbor Win! The player next to you won the Jackpot!” This reinforces the social connection derived from the physical sensor data.

### Detailed User Interface (UI) Mockup and Operational Logic for the Dealer Console

### Detailed Technical Description & Implementation Details:

In at least one embodiment relating to the specific human-machine interface (HMI) and the underlying control logic for the Live Dealer, the Wager-Based Gaming System implements a specialized Dealer Console equipped with a Dealer Performance Tracker (DPT). This subsystem functions as the primary control plane for the “Dealer-Controlled Jackpot Activation” (Innovative Element 1).

### 1. Dealer Console Hardware & UI Mockup:

The console is a 10-inch industrial-grade capacitive touchscreen with an integrated biometric fingerprint scanner and a physical, large-format “Event Trigger” button (mushroom style) with LED backlighting. The UI layout is divided into four distinct zones:
Zone A: Game State Monitor (Top): Displays the current game status (e.g., “Bets Closed,” “Dealing,” “Resolving”). It includes a “Remote Connection Indicator” showing the count of active remote players (e.g., “Live: 152 Users”) to remind the dealer of the virtual audience.
Zone B: Dealer Performance Tracker (Center-Left): This is the visualization of the DPT logic. It features a dynamic “Heat Meter” or “Streak Counter.” For example, in Baccarat, it displays a vertical bar representing “Consecutive Banker Wins.” As the dealer wins hands, the bar fills (Green->Yellow->Red).
Zone C: Jackpot Control Cluster (Center-Right): This area contains the virtual status of the “Mystery Jackpot.” By default, this zone displays a “Locked” icon with a countdown or condition tracker (e.g., “3 more wins to unlock”). When the DPT logic condition is met, this zone transforms to a pulsating “READY” state, and the physical button's LED backlight switches from Off to Flashing Gold.
Zone D: System Health & Alerts (Bottom): Displays connectivity status with the Wager-Based Gaming System Core Module and any important alerts (e.g., “Scanner Error”).

### 2. Dealer Performance Tracker (DPT) Logic:

The DPT is a software service running on the console's local controller, synchronized with the Core Module. It operates on a Conditional State Logic:
Input: It ingests game results automatically via the “Smart Shoe” (card reader) or digital table sensors.
Processing: It maintains a rolling buffer of the last $N$ game outcomes. It applies a rule set (e.g., IF Last_5_Outcomes==DEALER_WIN).
Feedback Loop:
   State 0 (Cold): Threshold not met. Physical button disabled (hardware lockout).
   State 1 (Warming): Threshold approaching (e.g., ⅘ wins). UI displays “Anticipation Animation” to cue the dealer to build hype verbally.
   State 2 (Hot/Armed): Threshold met. The logic sends an ARM_TRIGGER signal to the I/O controller. The physical button is electronically enabled. The UI flashes “JACKPOT AVAILABLE.”
   State 3 (Cooldown): After activation, the logic enforces a COOLDOWN TIMER (e.g., 10 minutes) during which the button cannot be re-armed, regardless of game outcomes, to prevent payout saturation.

### 3. Input Validation Logic:

To trigger the event, the dealer must perform a Two-Factor Action: (1) Place a verified finger on the biometric scanner, and (2) Depress the physical button within a 2-second window of authentication. This logic prevents accidental bumps or unauthorized activation by pit bosses or other staff.

### Practical Application:

The practical application of this specific UI and logic is the creation of a “Gamified Workflow” for the live dealer that directly integrates with the electronic wagering system. In conventional live dealer setups, the dealer's screen is purely administrative (game administration). In the Wager-Based Gaming System, the console becomes an instrument of game pacing and entertainment.

By visualizing the “Performance Tracker,” the system gives the dealer a script or narrative to follow (“Folks, the meter is in the red, one more win and I hit the button!”). This drives engagement for both Local Players (who see the physical button light up) and Remote Players (who see the “Heat Meter” replicated on their mobile screens). The computer is integral because it acts as the arbiter of the “Hot Streak.” A human pit boss cannot track, calculate, and authorize a multi-million dollar jackpot trigger based on a win streak in real-time with the necessary audit trails, the DPT logic provides the regulatory assurance that the “discretionary” trigger was actually earned according to the math model.

### Technological Improvement/Improved Computer Functioning:

This subject matter improves the technological process of Human-in-the-Loop Control Systems within regulated gaming environments. It addresses the problem of “authorized discretionary input.” In standard systems, allowing a human to trigger a random event is a security risk. This invention improves computer functioning by implementing a Hardware-Software Logic Gate.

The implementation of the DPT as a local logic service that physically enables/disables the input circuit of the trigger button is a specific technical improvement. It reduces network traffic by filtering invalid inputs at the edge (the console) rather than sending every button press to the server for validation. Only “Valid, Armed, and Authenticated” trigger events are transmitted to the Core Module. Furthermore, the integration of the Smart Shoe data feed directly into the DPT logic creates a seamless, automated feedback loop that removes data entry errors, ensuring the jackpot state is perfectly synchronized with the actual card outcomes. This minimizes latency between the physical card drop and the digital jackpot readiness, creating a responsive and immersive system.

### Example Walk-Through Scenario:

Scenario: A Live Dealer Blackjack table connected to the Wager-Based Gaming System.
1. Baseline: The table is active. The Dealer Console shows the “Game State” as Active. The “Heat Meter” is at 0. The physical “Event Button” is dark.
2. Gameplay: The dealer deals a hand. The Smart Shoe detects a “Dealer Blackjack.”
3. Logic Update: The DPT receives the “Dealer Blackjack” signal. The rule is “3 Dealer Blackjacks in 1 hour enables Jackpot.” The UI updates: “Streak: ⅓.”
4. Progression: Over the next 20 minutes, two more Dealer Blackjacks occur. The DPT updates the UI to “Streak: 3/3—JACKPOT ARMED.”
5. Hardware State Change: The DPT sends a signal to the console's microcontroller. The physical button's relay closes (enabling input), and the gold LED begins to strobe. The Touchscreen UI changes to a large “ACTIVATE MYSTERY JACKPOT” prompt.
6. Dealer Action: The dealer sees the cue. She announces to the camera, “We hit the trifecta! Who wants a jackpot?” She scans her thumb (verified in 0.5s) and slams the physical button.
7. Execution: The console sends the authenticated TRIGGER_EVENT command to the Core Module.
8. Feedback: The Core Module acknowledges. The Console UI transitions to “EVENT LIVE,” displaying the countdown of the jackpot animation playing on the player terminals.
9. Reset: Once the event concludes, the DPT enters “Cooldown” mode. The UI shows a greyed-out timer: “Next availability in 15:00.” The physical button light turns off.

### Timer System and Logic for the Unclaimed Fund Redistribution Process

### Detailed Technical Description & Implementation Details:

In at least one embodiment relating to the technical management of jackpot expiry and fund repurposing (Inventive Concept 65), the Wager-Based Gaming System implements a specialized Jackpot Lifecycle Manager (JLM) subsystem. This subsystem integrates a high-precision Distributed Timer System and a transactional Fund

### Redistribution Engine.

### 1. Distributed Timer System Architecture:

The Timer System is not a simple clock but a state-aware scheduling service (e.g., based on Quartz Scheduler or a Redis-backed delayed task queue) running on the First Server System. It manages the precise state transitions of a jackpot event using Network Time Protocol (NTP) to ensure synchronization across the Core Module, Casino Backend, and all Client Terminals (Physical ETGTs and Remote Interfaces).
State Machine: The JLM assigns a state to every jackpot event: STATUS_ACTIVE->STATUS_TRIGGERED->STATUS_CLAIM_WINDOW_OPEN->STATUS_CLAIMED OR STATUS_EXPIRED.
Countdown Logic: Upon a trigger event ($T_0$), the JLM initiates an immutable countdown timer (e.g., $T_{expiry}=T_0+600 \text{seconds}$). This expiry timestamp is broadcast to the winning terminal. The server enforces the expiry server-side; client-side timers are visual representations only.
Heartbeat Monitoring: The system monitors the connection status of the winning player. If a disconnection occurs (Remote Player) or a card removal occurs (Local Player) during the CLAIM_WINDOW, the timer persists server-side.

### 2. Unclaimed Fund Redistribution Logic:

The Fund Redistribution Engine executes a set of deterministic, pre-configured Redistribution Rules stored in the Casino Backend Database. These rules dictate the financial flow of expired funds to ensure regulatory compliance (funds must return to players, not the house).
Rule Hierarchy: The system queries a logic table:
   1. Primary Rule: Seed the next instance of the same jackpot pool (e.g., +50% of expired funds).
   2.Secondary Rule: Inject liquidity into a “High Priority” active pool (e.g., “Splash Pot” for active Baccarat tables).
   3. Tertiary Rule: Convert to “Community Bonus” credits distributed to currently active players.
Transactional Execution: When STATUS_EXPIRED is reached, the JLM executes an ACID-compliant transaction. It debits the Pending_Payout_Ledger and credits the target Jackpot_Pool_Ledger. This generates a unique Redistribution_Transaction_ID for auditing.
Notification Generation: The system generates a broadcast message: “Jackpot Unclaimed! $10,000 added to the Mini-Baccarat Pool!” to notify players of the liquidity injection.

### Practical Application:

The practical application of this system is the automated management of “Abandoned Win” scenarios in a high-volume, networked gaming environment. In traditional casinos, an unclaimed jackpot may result in a manual dispute or funds sitting in limbo. In the Wager-Based Gaming System, particularly with Remote Players who may suffer battery failure or network loss, “abandonment” is a technical state that may require immediate resolution.

The computer is integral because the redistribution may be instantaneous and mathematically verifiable. A human operator cannot manually transfer credits from an expired locked state to 50 different active terminals in real-time while updating the display meters simultaneously. The JLM provides the automated financial governance required to ensure that the “Return to Player” (RTP) percentages remain compliant even when specific wins are forfeited, maintaining the economic equilibrium of the casino ecosystem.

### Technological Improvement/Improved Computer Functioning:

This subject matter improves the technological process of State Management in Transactional Systems. It addresses the “Stale Lock” problem where resources (funds) are locked for a user who is no longer responsive.

The implementation improves computer functioning through:
1. Automated Liquidity Recycling: The logic ensures that system resources (credits) are not sequestered indefinitely. By automatically recirculating expired funds, the system maintains player engagement metrics without requiring fresh capital injection from the house.
2. Deterministic State Resolution: The use of server-authoritative timers prevents client-side manipulation (e.g., a hacked app trying to extend the claim window). The strict state machine ensures that a jackpot cannot be in a “superposition” of claimed and expired, it must resolve to one mathematical outcome.
3. Audit Trail Integrity: The system creates a cryptographic link between the Expired Event ID and the Redistribution Transaction ID. This creates a transparent data lineage for regulators, proving that the casino did not “absorb” the unpaid win but legitimately repurposed it according to the rules.

### Example Walk-Through Scenario:

Scenario: A Remote Player triggers a $5,000 Mystery Jackpot on Live Roulette but their phone battery dies immediately after the trigger.
1. Trigger ($T_0$): The Wager-Based Gaming System Core Module detects the win. It sets the Jackpot State to CLAIM_WINDOW_OPEN and starts a 5-minute timer.
2. Notification: The server attempts to send the “Claim Now” prompt to the Remote Interface. It receives no acknowledgement (Connection Lost).
3. Countdown: The Server Timer ticks down. The Physical ETGTs on the casino floor display a ticker: “Pending Jackpot Claim . . . 4:59 remaining.”
4. Expiry ($T_0+5 min$): The timer hits zero. The system receives no valid “Claim” signal (e.g., biometric verification) from the player.
5. State Transition: The JLM transitions the state to STATUS_EXPIRED.
6. Redistribution Execution:
   The Engine queries the Rules Table. Rule: “Split 50/50 between Next Reset Seed and Current Active ‘Hot’ Table.”
   Transaction A: $2,500 moved to the “Roulette Master Pool” (Next Seed).
   Transaction B: $2,500 moved to the “Live Blackjack Progressive” (currently the most active pool).
7. Broadcast:
   The Roulette meter resets to a higher-than-usual baseline.
   The Blackjack players see their jackpot meter suddenly jump by $2,500 with a notification: “Rollover Bonus Applied!”
8. Logging: The Casino Backend logs: Event_ID_555: Expired. Funds Redistributed via Trans_ID_999.

### Details on Authentication and Cryptographic Security for the Dealer-Controlled Jackpot Activation

### Detailed Technical Description & Implementation Details:

In at least one embodiment relating to the security and latency implications of human-initiated triggers in a regulated gaming environment (Innovative Element 1), the Wager-Based Gaming System implements a Cryptographic Dealer Command Protocol (CDCP) and a Latency-Masking Synchronization Layer.

### 1. Cryptographic Dealer Command Protocol (CDCP):

This protocol secures the physical link between the Dealer Console and the Wager-Based Gaming System Core Module.
Hardware Root of Trust: The Dealer Console is equipped with a Trusted Platform Module (TPM) 2.0 chip. This chip stores a unique, immutable private key generated during the manufacturing of the console.
Biometric Hashing: When the dealer scans their fingerprint to authorize a jackpot, the scanner generates a biometric template. This template is salt-hashed with a session-specific nonce. It is not stored as a raw image.
Payload Signing: When the physical button is pressed, the console constructs a data packet containing: {Timestamp, Dealer_ID, Session_ID, Biometric_Hash, Trigger_Command}. The TPM signs this packet using an Elliptic Curve Digital Signature Algorithm (ECDSA).
Server-Side Verification: The First Server System (Core Module) holds the public key for the console. Upon receipt, it verifies the signature. If the signature is valid and the timestamp is within a strict window (e.g., <200 ms drift), the command is processed. This prevents “Replay Attacks” where a malicious actor records a valid trigger signal and resends it later to manipulate outcomes.

### 2. Latency-Masking Synchronization:

The manual trigger is technically utilized to resolve the “State disparity” between fast-paced games (e.g., Baccarat) and slow-paced games (e.g., Roulette) connected to the same jackpot.
Pre-Fetch State: When the dealer presses the button, the system enters a “Pre-Fetch” mode. It does not immediately show the win. Instead, it broadcasts a background LOCK_STATE command.
Jitter Buffer: The Core Module utilizes a dynamic jitter buffer. It waits for acknowledgments from the slowest 95% of connected clients (Remote and Local) before broadcasting the RENDER_ANIMATION command. This ensures that a player on a fast fiber connection and a player on a slow 4G connection see the “Dealer presses button->Jackpot Explodes” sequence simultaneously, eliminating the “Spoiler Effect” caused by network latency.

### Practical Application:

The practical application of this security architecture is the prevention of Insider Fraud and Collusion. In a live casino environment, a corrupt dealer may try to signal a confederate player to bet heavily right before triggering a discretionary bonus. However, the CDCP ensures that the trigger is only valid if the Dealer Performance Tracker logic (server-side) agrees that the “Hot Streak” condition exists and the biometric identity matches the scheduled employee. The physical button becomes a cryptographically secured input device, not just a mechanical switch.

Furthermore, the practical application of the latency solution addresses the user experience in Hybrid Live/Online Tournaments. Without this synchronization, a remote player may see the jackpot result on their phone seconds after hearing the cheers from the casino floor via the video feed, breaking the immersion. The implemented logic forces the physical machine to “wait” milliseconds for the remote signal to catch up, ensuring a unified communal experience which is important for the “Neighbor Luck Share” mechanic to feel fair.

### Technological Improvement/Improved Computer Functioning:

This subject matter improves the technological process of Input Validation in Real-Time Transactional Systems.
1. Non-Repudiation: By binding the biometric hash to the hardware signature of the console, the system creates an undeniable audit trail. It improves computer functioning by automating the “Chain of Custody” for high-value events. The computer system may mathematically prove who pressed the button and which device was used, replacing error-prone manual logbooks.
2. Deterministic State Synchronization: The use of the manual trigger as a “Synchronization Anchor” improves network efficiency. Instead of constantly synchronizing game states (high bandwidth), the system uses the rare manual trigger event to force a “Hard Sync” across the network. This reduces the baseline data overhead for the network while ensuring high precision exactly when it matters (the jackpot event).
3. Security Architecture: The separation of the “Trigger Request” (Dealer Console) from the “Outcome Generation” (Server RNG) via a cryptographic boundary ensures that even if the physical console is physically tampered with, the attacker cannot force a “Win” outcome, only a “Request.”

### Example Walk-Through Scenario:

Scenario: A Dealer at Table 5 attempts to trigger a jackpot during a “Hot Streak.”
1. Authentication: The Dealer places her finger on the sensor. The console validates the print against the local encrypted cache and generates a Biometric_Token.
2. Input: The Dealer hits the “Big Red Button.”
3. Signing: The Console's TPM constructs a packet: [Trigger_Request|Dealer_ID: 55|Token: XYZ|Time: 10:00:00.005]. It signs this payload with its Private key.
4. Transmission: The packet is sent via TLS to the Wager-Based Gaming System Core Module.
5. Verification:
   The Core Module checks the signature. Valid.
   The Core Module checks the Dealer Performance Tracker. Table 5 has 6 consecutive wins. Condition Met.
   The Core Module checks the Timestamp. Latency is 10 ms. Acceptable.
6. Synchronization: The Core Module sends PREPARE_ANIMATION to 200 connected devices.
7. Latency Handling:
   Device A (Local) reports ready in 2 ms.
   Device B (Remote 4G) reports ready in 150 ms.
   The Core Module waits 150 ms.
8. Execution: The Core Module sends PLAY_NOW.
9. Result: Both Device A and Device B display the explosion animation at exactly 10:00:00.200. The dealer sees the confirmation light on the console turn green.

### Security Protocols for External Funding Mechanisms

### Detailed Technical Description & Implementation Details:

In at least one embodiment relating to the security architecture for integrating external data sources (Third-Party Sponsors and Social Media Platforms) into a regulated wagering environment (Innovative Element 2), the Wager-Based Gaming System implements a Sandboxed Data Ingestion Architecture featuring a Logical Air-Gap Protocol.

### 1. Network Topology & The Sandboxed Verification Module (SVM):

The system physically and logically separates the External Network (Public Internet, Sponsor APIs, Social Platforms) from the Internal Gaming Network (Game Logic, RNG, Player Balances) using a Demilitarized Zone (DMZ). The Sandboxed Verification Module (SVM) resides within this DMZ.
Input Sanitization: The SVM acts as a reverse proxy and content filter. It terminates all external SSL/TLS connections. When receiving data (e.g., a JSON payload from a social media webhook or a financial transaction record from a sponsor), the SVM performs deep packet inspection and schema validation. It strips all executable code, external links, and metadata, extracting only the specific variables required for the game (e.g., Transaction_ID, Amount, Player_Reference).
Protocol Translation: The SVM does not simply forward the external message. It translates the validated data into a proprietary, internal binary protocol used by the Wager-Based Gaming System Core Module. This ensures that even if an external payload contains a “Zero-Day” exploit targeting web servers, the internal game server-which only speaks the proprietary binary protocol-cannot parse or execute it.

### 2. Unidirectional Data Flow (The “Data Diode”):

To prevent the compromise of the Core Module, the communication link between the SVM and the Internal Network is configured as a Unidirectional Data Flow for control commands.
The SVM pushes verified “Events” (e.g., EVENT_FUNDING_RECEIVED) to an internal Message Bus (e.g., Kafka or RabbitMQ).
The Wager-Based Gaming System Core Module subscribes to this bus. It pulls messages when it is ready to process them. The Core Module never opens a listening port to the DMZ; it only establishes outbound connections to the trusted Message Bus.
This architecture ensures that an attacker compromising the SVM cannot initiate a direct connection to the Game Server or flood it with requests (Denial of Service), as the Game Server controls the rate of ingestion.

### 3. Financial Isolation Logic:

For Third-Party Sponsored Contributions, the system uses a Shadow Ledger. External funds are deposited into a non-gaming bank account. The SVM verifies this deposit via banking APIs. Upon verification, it instructs the Casino Backend System to create “Shadow Credits” in a specific Sponsorship Pool. These credits are locked and cannot be withdrawn as cash by players; they may only be consumed as “Promotional Wagers.” The Wager-Based Gaming System Core Module treats these credits differently in the game logic (e.g., non-cashable turnover), ensuring that external funding does not commingle with or corrupt the integrity of the player's actual cash balance until a legitimate win occurs.

### Practical Application:

The practical application of these security protocols is the enablement of “Open API” features in a “Closed Garden” regulatory environment. Modern casinos want to integrate with digital ecosystems (e.g., “Bet with WeChat,” “Sponsored Jackpots by Rolex”), but regulations strictly prohibit connecting slot machines or table game servers to the open internet due to hacking risks.

This invention provides the practical “Airlock” mechanism. It allows a Remote Player on a mobile device to interact with a Twitter campaign, and for that interaction to result in a tangible change on a physical ETGT on the casino floor (e.g., unlocking a bonus), without the physical ETGT ever connecting to Twitter. The computer is integral because the validation, translation, and re-encryption of these messages must happen in milliseconds to keep the user experience seamless. A human compliance officer cannot manually verify every social share or sponsor micro-transaction in real-time; the SVM automates this compliance gateway.

### Technological Improvement/Improved Computer Functioning:

This subject matter improves the technological process of Cyber-Physical System Security in gaming.
1. Attack Surface Reduction: By implementing the Protocol Translation step (JSON to Internal Binary), the invention neutralizes entire classes of web-based attacks (SQL Injection, XSS, Remote Code Execution) before they reach the important RNG or Accounting systems.
2. Fault Isolation: The Sandboxed architecture ensures that a failure in an external API (e.g., Facebook changes its API format, causing the listener to crash) stays contained within the DMZ. The Wager-Based Gaming System Core Module continues to operate standard games without interruption, improving overall system reliability (uptime).
3. Asynchronous State Integrity: The use of the Message Bus for internal signaling allows the game server to process external rewards between game cycles. This prevents a “State Conflict” where an external bonus arrives while the RNG is calculating a result, ensuring that the game logic remains deterministic and bug-free.

### Example Walk-Through Scenario:

Scenario: A Malicious Actor attempts to exploit the “Social Media Referral” feature to crash the Jackpot Server.
1. Attack: The attacker sends a malformed HTTP POST request to the Casino's Social Media Webhook endpoint, mimicking a “Viral Share” event but embedding a malicious script in the Player ID field intended to execute a database command.
2. Interception (SVM): The request hits the firewall and is routed to the Sandboxed Verification Module.
3. Validation Failure:
   The SVM attempts to validate the HMAC signature using the stored Social Platform Secret. The signature fails (because the attacker doesn't have the secret).
   Even if the signature was bypassed, the SVM's schema validator checks the Player_ID field. It expects a 16-digit integer. It sees a string of code.
4. Rejection: The SVM immediately drops the packet and logs the IP address to a “Blocklist.”
5. Isolation: Because the SVM is decoupled, the Wager-Based Gaming System Core Module (located on the internal network) is completely unaware of the attack. It continues serving the live Baccarat game to legitimate players with zero latency impact.
6. Legitimate Flow: Simultaneously, a legitimate Remote Player shares a link. The SVM validates the signature, confirms the integer ID, translates it into a binary OPCODE_GRANT_BONUS, and queues it. The Core Module picks it up and grants the bonus.

### Computational Details for Loyalty-Based Dynamic Jackpot Odds Modification

### Detailed Technical Description & Implementation Details:

In at least one embodiment relating to the non-abstract nature of “personalized odds,” the Wager-Based Gaming System implements a High-Frequency Probability Re-Weighting Architecture driven by a Predictive LTV (Lifetime Value) Engine. This architecture moves beyond simple static lookup tables (e.g., “Gold Tier=2×”) to a continuous, computationally intensive process that remodels the Random Number Generator (RNG) distribution curves in real-time.

### 1. The Jackpot Odds Adjustment Engine (JOAE) Architecture:

The JOAE is implemented as a Stream Processing Application (utilizing technologies similar to Apache Flink or Kafka Streams) capable of processing thousands of events per second. It does not merely read a database value, it executes a Multi-Variate Optimization Function for every single game initiation request sent to the Core Module.
Input Vector: The engine constructs a state vector $S_t$ for player $P$ at time $t$, containing variables: $\{Tier, Session\_Loss, Chum\_Probability, Theoretical\_Win, Time\_On\_Device}$.
LTV Prediction Model: The engine feeds $S_t$ into a pre-trained Machine Learning model (e.g., Random Forest or Gradient Boosting Regressor) hosted in memory. This model outputs a Predicted_LTV_Risk_Score.
Probability Re-Weighting Logic: The system dynamically alters the acceptance range of the RNG. In a standard system, a jackpot triggers if $RNG(1, N)==1$. In this invention, the system defines a dynamic acceptance range $[1, K]$, where $K$ is calculated as:

$$\$\$K = ∖ text \{ Base ∖ \_ Range \} ∖ times ( 1 + ∖ text \{ Sigmoid \} text \{ LTV ∖ \_Score \} ∖ times ∖ text \{ Current ∖ \_Loss ∖ \_Velocity \} ) ) \$\$$$

This calculation is non-trivial because it may require floating-point operations and matrix multiplications to be executed within the <50 ms “Game Logic Window” allowed by gaming regulators, requiring dedicated hardware acceleration (e.g., GPU or FPGA offloading) on the server.

### 2. Computational Integrity:

To ensure regulatory compliance, the “Re-Weighted” odds are deterministic based on the input snapshot. The system generates a Cryptographic Proof of Odds for every hand. It hashes the Input Vector and the resulting $K$ value, storing them in an immutable audit log. This proves that the odds modification was the result of a consistent mathematical rule application, not arbitrary dealer favoritism.

### Practical Application:

The practical application of this technology is the automation of “Casino Host” intuition at a massive scale. In a physical setting, a human host may see a VIP losing and manually offer a “free play” coupon to prevent them from leaving. This invention automates that retention mechanic directly into the mathematics of the game itself.

The computer is integral because no human may calculate a regression analysis on a player's lifetime betting history, cross-reference it with their current session loss rate, and adjust the statistical parameters of a random number generator in the 200 milliseconds between a “Deal” button press and the card delivery. The invention uses the computer not just as a calculator, but as an active, real-time agent that modulates the “physics” of the gaming environment (probability) to optimize an economic outcome (retention) based on predictive modeling.

### Technological Improvement/Improved Computer Functioning:

This subject matter improves the technological process of Real-Time Decision Systems in High-Frequency Transaction Environments.
1. Optimization of Retention Mechanics: Prior art relies on “Post-Game” rewards (e.g., mailers sent days later). This invention improves the process by moving the retention logic into the “In-Game” loop. By dynamically adjusting the RNG weights during the session based on LTV predictions, the system solves the technical problem of “latency in retention actions,” addressing player churn at the exact moment it is statistically most to occur.
2. Dynamic Resource Allocation: The system computationally optimizes the allocation of the “Jackpot Budget.” Instead of distributing the Return to Player (RTP) randomly, the LTV Engine directs the “Luck” (statistical variance) toward players where it generates the highest marginal utility for the casino ecosystem. This is a technical optimization of the gaming loop's financial efficiency.
3. Stateful Probability Management: The invention improves computer functioning by introducing Stateful RNG contexts. Conventional RNGs are stateless. This system maintains a persistent “Luck Context” for each player session that evolves over time, requiring a novel memory architecture to manage thousands of concurrent, evolving probability states without race conditions.

### Example Walk-Through Scenario:

Scenario: Player X, a high-value client, is playing Live Blackjack on a DETG but is experiencing a “cold streak” (10 consecutive losses).
1. Data Ingestion: The Wager-Based Gaming System Core Module detects the 10th loss. It pushes a Game_End_Event to the JOAE.
2. LTV Analysis: The JOAE updates the Current_Loss_Velocity variable. The embedded ML model predicts a “Chum Probability” of 85% within the next 5 minutes if no win occurs.
3. Optimization: The system logic determines that retaining Player X is worth a specific investment. It triggers the “Odds Surge” protocol.
4. Re-Weighting:
   Standard Mystery Jackpot Trigger Chance: 1 in 500. (Target: 1).
   The algorithm calculates a modifier based on the Chum Risk. New Modifier: 5.0×.
   New Trigger Target Range: [1-5].
5. Execution: Player X places the bet for Hand 11. The RNG generates the number ‘4’.
   Under standard rules, this is a loss (4 !=1).
   Under the Re-Weighted logic, this is a WIN (4 is within [1-5]).
6. Outcome: The Mystery Jackpot triggers. Player X receives a $500 bonus.
7. Feedback Loop: The JOAE records the win. The “Chum Probability” metric drops to 10%. The Odds Modifier for Hand 12 slowly decays back toward the baseline, having successfully “corrected” the negative experience through algorithmic intervention.

### Mathematical Justification and Specific Formulas for the Dynamic Acceleration Algorithm Used in Dynamic Jackpot Pooling

### Detailed Technical Description & Implementation Details:

In at least one embodiment relating to the specific mathematical underpinnings of the Dynamic Jackpot Pooling (Innovative Element 4), the Wager-Based Gaming System implements a Dynamic Acceleration Algorithm governed by a PID (Proportional-Integral-Derivative) Controller Logic adapted for financial transaction processing. This logic is executed by the Wager Contribution System within the Core Module.

### 1. The Acceleration Formula:

The system calculates the Effective Contribution Rate ($R {eff}$) for a given time window $t$ based on the Base Rate ($R_{base}$) (e.g., 1.0% of wager) and a dynamic Acceleration Multiplier ($M_{acc}$).

The formula is defined as:

$$\$\$R\_ \{ eff \} ( t ) = R\_ \{ base \} ∖ times M\_ \{ acc \} ( C\_t ) \$\$$$

Where $C_t$ is the Concurrency Metric (count of active players) at time $t$.

To prevent “Runaway Inflation” (where the pool grows too fast to be sustainable) or “Stagnation” (where it moves too slow to interest players), the multiplier function $M_{acc}$ uses a Logistic Sigmoid Curve rather than a linear progression:

$$\$\$M\_ \{ a c c \} ( C\_t ) = 1 + ∖ frac \{ K \} \{ 1 + {e}^{∧} \{ - k ( C\_t - C\_ 0 ) \} \} \$\$$$

$K$: The maximum boost cap (e.g., 2.0, meaning max 3× contribution).
$k$: The steepness of the curve (sensitivity to new players).
$C_0$: The midpoint of the curve (the “Target Concurrency”).

This mathematical model ensures that adding players when the floor is empty has a high impact (steep growth), but adding players when the floor is already saturated has diminishing returns (flattening curve), optimizing the “Excitement-to-Cost” ratio.

### 2. Stability & Hysteresis Logic:

To prevent Network Instability caused by rapid rate updates (e.g., a player logging in and out repeatedly causing the rate to jitter between 1.5% and 1.6%), the system implements Tiered Response Thresholds with Hysteresis.

The system defines discrete Tiers (e.g., Tier 1: 0-50 players, Tier 2: 51-150 players). To transition from Tier 1 to Tier 2, $C_t$ must exceed the upper bound (50) by a Deadband Buffer ($\delta$, e.g., +5 players).

$$Upgrade Trigger : \$C\_t > ( Tier\_ \{ limit \} + ∖ delta ) \$$$

$$Downgrade Trigger : \$C\_t < ( Tier\_ \{ limit \} + ∖ delta ) \$$$

This “Schmitt Trigger” logic ensures that the global system state remains stable despite minor fluctuations in connectivity, reducing database write operations and network broadcast traffic by filtering out high-frequency noise in the player count.

### Practical Application:

The practical application of these mathematical formulas is the algorithmic stabilization of the casino's jackpot economy in a hybrid local/remote environment. In a purely physical casino, player count fluctuates slowly. In the Wager-Based Gaming System, a “Flash Crowd” of 1,000 remote players may join in seconds via a push notification. A linear model would bankrupt the jackpot reserve or break the display meters.

The computer is integral because it acts as a Real-Time Economic Governor. It constantly samples the network load ($C_t$), computes the derivative of the player count change (rate of arrival), and adjusts the financial parameters ($R_{eff}$) of thousands of concurrent wagers within the 50 ms betting window. This prevents the “Overshoot” problem common in feedback loops, ensuring the jackpot grows attractively without exceeding the casino's liability cap.

### Technological Improvement/Improved Computer Functioning:

This subject matter improves the technological process of Load-Dependent State Management.
1. Network Traffic Optimization: By implementing the Hysteresis Logic, the system significantly reduces the frequency of Broadcast_State_Change messages sent to the 500+ connected ETGTs. Instead of broadcasting every time a player joins (Linear), it only broadcasts when a stable Tier Change occurs (Step-Function). This conserves bandwidth for important video and game data.
2. Computational Determinism: The use of the Logistic Sigmoid Function provides a bounded, deterministic output for any possible input. This improves system reliability compared to open-ended linear multipliers which may result in integer overflow or logic errors during extreme load testing (e.g., a botnet simulation).
3. Dynamic Liability Scaling: The system improves the management of the “Jackpot Liability” variable in the database. By coupling the contribution rate to the player count mathematically, the system automatically “funds” the excitement. When player count is high (high liquidity), the rate flattens to save margin. When player count is low, the rate accelerates to “buy” engagement. This is an automated optimization of the system's utility function.

### Example Walk-Through Scenario:

Scenario: A “Jackpot Happy Hour” begins, attracting both local and remote players.

$$1. Inital State : Active Players ( \$C\_t\$ ) = 40. Tier 1. Multiplier = 1. x .$$

2. Influx: A push notification goes out. 20 remote players join instantly. $C_t=60$.
3. Logic Check (Hysteresis):
   Tier 1 Limit is 50.
   Deadband ($\delta$) is 5.

$$Threshold to Upgrade = 55.$$

$$Current ( 60 ) > Threshold ( 55 ) . Trigger Upgrade .$$

4. Calculation: The Wager Contribution System executes the Sigmoid function.

$$Inputs : \$C\_t - 60 \$ , \$C\_ 0 = 100 \$ , \$K = 2 \$ .$$

Resulting $M_{acc}\approx 1.4$.
5. Execution:
   The Core Module updates the Global_Contribution_Rate to Base*1.4.
   It broadcasts EVENT_TIER_UP to all terminals.
6. Stabilization: 7 players disconnect immediately ($C_t=53$).

$$Downgrade Threshold = \$50 - 5 = 45 \$ .$$

$$Current ( 53 ) > Downgrade Threshold ( 45 ) .$$

Result: The system remains in Tier 2. The contribution rate stays at 1.4×. No network broadcast is sent.

The system successfully absorbed the fluctuation without jittering.

### Mystery Jackpot Innovative Concepts & Example Embodiments

### Innovative Concept 1—Multi-Casino Progressive Mystery Jackpot

Identification of Concept: This innovative concept involves implementing a progressive mystery jackpot system that spans multiple casinos and is triggered when a predetermined number of players engage in the same Dealer-controlled Electronic Table Game (DETG) within a defined time window across different casino locations. The notable features include:
1. A networked system connecting DETGs across multiple casino properties
2. Real-time tracking of player engagement across all connected tables
3. A progressive jackpot pool that accumulates based on play across all locations
4. A trigger mechanism based on reaching a threshold number of simultaneous players within a time window
5. Mystery jackpot award that may be won by any qualifying player across the network

This concept may be implemented in live dealer electronic game table systems and DETGs by leveraging existing network infrastructure to create a wide area progressive system specifically designed for table games. It may require integration of player tracking, real-time game state monitoring, and a centralized jackpot management system.

### Sequence Diagram Components:

1. ELECTRONIC TABLE GAME TERMINAL (ETGT): The physical electronic table game device at each casino
2. Player A, Player B: Individual players at various ETGTs across different casinos
3. Table Game Server: Manages game logic and state for each ETGT
4. Casino Management System (CMS): Tracks player activity and manages casino operations
5. Wide Area Progressive (WAP) Server: Manages the multi-casino progressive jackpot
6. Player Tracking Server: Manages player accounts and loyalty programs
7. Time Synchronization Server: Ensures accurate timing across all networked components
8. Network Communication Components: Handles data transfer between casinos and central systems

Implementation Details: To enable this innovative concept on an ELECTRONIC TABLE GAME TERMINAL, several notable modifications and additions are required:
1. Enhanced Network Connectivity: Each ETGT may be equipped with a secure, high-speed network interface capable of real-time communication with both local casino systems and the centralized WAP server. This may involve implementing dedicated VPN tunnels or other secure communication protocols to ensure data integrity and low latency across geographically dispersed locations.
2. Real-time Player Engagement Tracking: The ETGT software may be updated to continuously monitor and report player engagement status. This includes detecting when a player joins or leaves the game, as well as tracking active betting periods. This information is notable for determining when the threshold for jackpot triggering has been met.
3. Jackpot Contribution Mechanism: The ETGT may be configured to automatically contribute a portion of each wager to the progressive jackpot pool. This may require integration with the WAP server to ensure accurate and timely updates to the jackpot amount.
4. Time Synchronization: To accurately determine if the required number of players are engaged within the specified time window, all ETGTs may be precisely synchronized. This may involve implementing a Network Time Protocol (NTP) client on each ETGT that regularly synchronizes with a central time server.
5. Dynamic Jackpot Display: The ETGT interface may be updated to include a prominent, real-time display of the current progressive jackpot amount. This display should be updated frequently to create excitement and encourage participation.
6. Jackpot Triggering and Award Mechanism: When the WAP server determines that the jackpot conditions have been met, it may be able to instantly notify all connected ETGTs. The selected ETGT must then be able to interrupt normal game play to announce and award the jackpot to the winning player.

These implementation details enable the innovative concept to be deployed in live dealer electronic game table systems and DETGs by creating a cohesive, real-time system that spans multiple properties while maintaining the integrity and excitement of individual table games. This approach is differentiated from conventional ETGTs and EGMs of the prior art by its ability to create a shared, cross-property jackpot experience specifically tailored for table games, which traditionally have not been included in wide area progressive systems.

Example Walk-through Scenario: Let's walk through an example of how this multi-casino progressive mystery jackpot may play out:
1. The WAP server initializes the progressive jackpot at $100,000 and sets the trigger condition to 100 simultaneous players within a 5-minute window.
2. Players at various casinos begin playing at DETGs connected to the system. Each wager contributes a small percentage to the progressive jackpot.
3. At Casino A, Player A sits down at a DETG blackjack table. The ETGT detects the new player and sends this information to the local CMS, which then forwards it to the WAP server.
4. Similar actions occur at Casinos B, C, and D as more players join DETGs.
5. The WAP server continuously monitors player counts across all connected casinos. As more players join, the jackpot amount steadily increases, with all ETGT displays updating in real-time.
6. As the player count approaches the trigger threshold, excitement builds across all participating casinos.
7. Finally, Player B at Casino C sits down at a baccarat DETG, bringing the total player count to 100 within the 5-minute window.
8. The WAP server immediately detects that the trigger condition has been met. It randomly selects one of the 100 active players as the winner.
9. The WAP server sends a jackpot win notification to all connected ETGTs, with special information sent to the winning player's ETGT.
10. All ETGTs briefly interrupt their games to announce the jackpot win. The winning ETGT at Casino C displays a celebratory animation and informs Player A that they've won the progressive jackpot.
11. The casino staff at Casino C verify the win and initiate the payout process for the $150,000 jackpot (which had grown from the initial $100,000).
12. Once the win is verified and paid, the WAP server resets the progressive jackpot to its starting value, and the cycle begins anew.

This scenario demonstrates how the system creates a shared experience across multiple properties, building excitement and encouraging play at DETGs.

Player Interaction: Players interact with this system primarily through normal play at the DETGs. Here's how an example player experience may unfold:
1. The player approaches a DETG and observes the prominently displayed progressive jackpot amount.
2. After sitting down, the player logs in using their player card or enters their details on the ETGT interface.
3. The player places their wagers for the primary game (e.g., blackjack, baccarat) as normal.
4. With each wager, the player sees a small animation indicating their contribution to the progressive jackpot.
5. Throughout their play session, the player may watch the jackpot amount increase in real-time.
6. Periodically, the ETGT display may show animations or messages indicating how close the system is to reaching the trigger threshold (e.g., “Only 10 more players needed for a chance at the $150,000 jackpot!”).
7. If the jackpot is triggered, the player experiences a brief but exciting interruption to their game as the win is announced.
8. If they are the lucky winner, they are guided through the verification and payout process by both the ETGT interface and casino staff.

This interaction is novel for DETGs as it creates a shared, cross-property experience that was previously only available on slot machines. It adds an extra layer of excitement to table games without significantly altering the specific gameplay.

Distinguishing Innovative Concepts: Several novel implementation details and concepts enable this innovative concept to be deployed in live dealer electronic game table systems and DETGs:
1. Table Game-Specific Wide Area Progressive: This system is uniquely designed for table games, which have traditionally been excluded from wide area progressive systems due to their slower pace and more complex gameplay compared to slot machines.
2. Real-Time Player Engagement Tracking: Unlike slot machines where player engagement is simple to track, this system must accurately monitor when players join and leave tables, as well as when they are actively betting, across multiple game types and casinos.
3. Cross-Game Jackpot Eligibility: This system allows players of different table games (e.g., blackjack, baccarat, roulette) to all contribute to and be eligible for the same jackpot, creating a unified experience across diverse game types.
4. Time-Window Based Trigger: Instead of traditional jackpot triggers based on specific card combinations or wager amounts, this system uses a novel time-window approach to create urgency and excitement.
5. Seamless Integration with Live Dealer Games: This system is designed to work with both fully electronic and live dealer hybrid games, requiring careful integration to not disrupt the flow of live-dealt games.

These concepts differentiate the ETGT from conventional EGMs by creating a more social, interconnected experience that maintains the unique appeal of table games while adding the excitement of a massive, multi-casino jackpot.

### Distinguishing Inventive Steps:

1. Dynamic Player Threshold Calculation: The system continuously calculates and adjusts the player threshold required to trigger the jackpot based on current casino activity levels, time of day, and other factors. This ensures that the jackpot remains achievable and exciting regardless of overall player volume.
2. Adaptive Contribution Rates: The system dynamically adjusts the percentage of each wager that contributes to the jackpot based on the current jackpot size, player volume, and game type. This allows for faster growth during peak times and maintains excitement during slower periods.
3. Multi-Game State Synchronization: The system implements a novel method for synchronizing game states across different table game types, allowing for seamless jackpot integration without disrupting the unique rhythm of each game.

These steps are unique to DETGs and live dealer systems as they address the specific challenges of integrating a progressive jackpot into diverse table games with varying paces and structures. They enable a cohesive jackpot experience across different game types and properties, which is not possible with conventional EGMs designed for single-game, single-property progressives.

35 USC 101 Considerations: The technical implementation of this Innovative Concept is patentable subject matter under 35 USC 101 for several reasons:
(a) This concept goes beyond a mere abstract idea by capturing a specific improvement over prior art in the field of electronic table games. It solves the technical challenge of implementing a wide area progressive system for diverse table games across multiple properties, which was previously not feasible due to the complex nature of table game play and the difficulties in synchronizing across different game types and locations.
(b) The innovative concept is directed to an improvement in computer functionality which solves a problem in an existing technological process. Specifically, it addresses the challenge of real-time player engagement tracking and jackpot triggering across a distributed network of heterogeneous game types. This may require novel solutions for data synchronization, time-window based event triggering, and seamless integration with live dealer games.
(c) The concept integrates the improvement into a practical application which enables a discernible advancement in computer functionality. It creates a new type of networked gaming system that may monitor and respond to complex, time-sensitive events across multiple locations and game types. This practical application enhances the functionality of electronic table games, creating new possibilities for player engagement and casino operations.

The implementation may require specific hardware configurations and software algorithms that go beyond generic computer components, including specialized network protocols for low-latency communication, advanced data synchronization techniques, and real-time distributed event processing. These technical elements transform the abstract idea of a multi-casino jackpot into a concrete, technological improvement in the field of electronic gaming.

Data Input: The system may require various types of data inputs from players and other casino systems:
1. Player Identification: When a player joins a DETG, they must input their player ID (e.g., via player card or manual entry). This allows the system to track individual player engagement and ensure accurate jackpot eligibility.
2. Wager Information: Each bet placed by a player may be accurately captured and transmitted to both the local game server and the WAP server. This includes the bet amount, type of bet, and timestamp.
3. Game State Information: The system must continuously receive updates on the state of each game (e.g., dealing in progress, betting open, game in progress) to accurately determine player engagement.
4. Dealer Actions: For live dealer games, the system must capture dealer actions such as opening and closing betting windows, dealing cards, and resolving games.
5. Time Synchronization Data: Regular time synchronization data may be received from the central time server to ensure accurate tracking of the jackpot trigger window.

These data inputs enable the system to maintain an accurate, real-time view of player engagement across all connected DETGs, which is notable for the novel time-window based jackpot trigger mechanism.

### Component Interactions and Procedural Steps:

1. ETGT to Table Game Server:
   ETGT sends player login/logout events
   ETGT transmits each wager placed
   ETGT reports game state changes
   Table Game Server validates and processes game outcomes
2. Table Game Server to CMS:
   Sends aggregated player activity data
   Reports game performance metrics
   Receives configuration updates (e.g., betting limits, game rules)
3. CMS to WAP Server:
   Transmits real-time player engagement data
   Sends jackpot contribution amounts
   Receives jackpot updates and trigger notifications
4. WAP Server to Player Tracking Server:
   Verifies player eligibility for jackpot
   Updates player accounts with jackpot contributions and wins
5. WAP Server to Time Synchronization Server:
   Regularly synchronizes time to ensure accurate trigger window tracking
6. WAP Server to all connected systems:
   Broadcasts current jackpot amount updates
   Sends jackpot win notifications

Notable novel steps in this flow include:
Real-time aggregation and analysis of player engagement data across multiple game types and properties
Dynamic calculation of jackpot trigger conditions based on current network-wide player activity
Seamless interruption of diverse game types to announce and award jackpots without disrupting overall game flow

These interactions and steps are unique to DETGs and live dealer systems as they must handle the complexities of table game play while maintaining a cohesive, exciting jackpot experience across multiple games and properties.

Data Processing: The system performs several notable processing steps:
1. Player Engagement Calculation: The WAP server continuously processes incoming player data to determine the current number of active players across all connected DETGs.
2. Time Window Tracking: The system maintains a rolling time window (e.g., 5 minutes) and constantly updates the player count within this window.
3. Jackpot Trigger Evaluation: With each player engagement update, the system evaluates whether the trigger condition (e.g., 100 players within 5 minutes) has been met.
4. Random Winner Selection: When the trigger condition is met, the system randomly selects a winner from all eligible players.
5. Jackpot Amount Calculation: The system continuously recalculates the current jackpot amount based on incoming contributions from all connected DETGs.

These processing steps are novel in their application to table games, requiring complex real-time data analysis across diverse game types and locations.

Outputs and Responses: The system provides various outputs and responses:
1. To Players:
   Real-time jackpot amount updates on ETGT displays
   Notifications of nearing jackpot trigger thresholds
   Jackpot win announcements and celebrations
   Personal contribution tracking
2. To Dealers:
   Notifications of jackpot status and near-triggers
   Instructions for handling jackpot wins during live games
3. To Casino Management:
   Real-time reports on jackpot status and player engagement
   Alerts for unusual activity or system issues
   Jackpot win verifications and payout instructions

These outputs create a dynamic, exciting atmosphere unique to this DETG jackpot system, enhancing the table game experience beyond what's possible with conventional EGMs.

Data Storage and Reporting: The system stores and reports various data types:
1. Player Engagement Logs: Detailed records of when players join and leave games, their active betting periods, and contributions to the jackpot.
2. Jackpot History: A complete record of jackpot amounts, trigger events, and winners.
3. Game Performance Metrics: Data on how the jackpot system affects player behavior and game performance across different properties and game types.

This data is notable for regulatory compliance, game optimization, and creating personalized player experiences unique to this DETG jackpot system.

Error Handling and Security Measures: The system implements robust error handling and security:
1. Network Failure Handling: In case of communication disruptions, ETGTs may operate in a degraded mode, accumulating jackpot contributions locally until reconnection.
2. Time Synchronization Checks: Regular verification of time synchronization across all components to ensure fair jackpot triggering.
3. Encryption and Authentication: All network communications are encrypted, and components mutually authenticate to prevent tampering or false jackpot triggers.

These measures ensure the integrity of the jackpot system across multiple properties, a unique challenge for DETG implementations.

End of Interaction: When a jackpot is awarded, the system:
1. Freezes the jackpot amount on all displays
2. Notifies all ETGTs of the win, triggering celebratory animations
3. Initiates the winner verification and payout process
4. Resets the progressive jackpot to its starting value
5. Clears the current player engagement count and time window
6. Logs all details of the winning event for auditing and reporting purposes
7. Resumes normal operation, beginning a new cycle of jackpot accumulation

This end-of-cycle process is unique to this DETG system as it must coordinate the reset across multiple properties and game types simultaneously, ensuring a seamless transition back to normal play for all connected tables.

Now, let's proceed with the next three innovative concepts:

### Innovative Concept 2—Side Bet-Driven Mystery Jackpot Funding

Identification of Concept: This innovative concept involves a mystery jackpot system for Dealer-controlled Electronic Table Games (DETGs) that is funded solely through side bets, with a percentage of each side bet allocated to a growing jackpot pool. Notable features include:
1. A dedicated side bet option for jackpot participation
2. Real-time tracking of side bet amounts across all connected DETGs
3. Dynamic allocation of side bet funds to the jackpot pool
4. A mystery trigger mechanism for awarding the jackpot
5. Integration with various table game types (e.g., blackjack, baccarat, roulette)

This concept may be implemented in live dealer electronic game table systems and DETGs by modifying the betting interface to include a specific jackpot side bet option and creating a centralized system for managing the accumulated jackpot funds across multiple games and potentially multiple properties.

### Sequence Diagram Components:

1. ELECTRONIC TABLE GAME TERMINAL (ETGT): The physical electronic table game device
2. Player A, Player B: Individual players at various ETGTs
3. Table Game Server: Manages game logic and state for each ETGT
4. Jackpot Management System (JMS): Tracks side bets and manages the jackpot pool
5. Random Number Generator (RNG): Provides randomization for mystery jackpot triggers
6. Casino Management System (CMS): Oversees overall casino operations
7. Player Tracking System: Manages player accounts and loyalty programs
8. Accounting System: Handles financial transactions and reporting

Implementation Details: To enable this innovative concept on an ELECTRONIC TABLE GAME TERMINAL, several notable modifications and additions are required:
1. Enhanced Betting Interface: The ETGT may be updated to include a clearly marked area for placing the jackpot side bet. This interface should be intuitive and visually distinct from the main game betting areas.
2. Real-time Side Bet Tracking: The ETGT software may be modified to instantly recognize and report jackpot side bets to the Jackpot Management System. This may require implementing a secure, low-latency communication protocol.
3. Dynamic Jackpot Display: A prominent display showing the current jackpot amount may be integrated into the ETGT interface. This display should update in real-time as side bets are placed across all connected tables.
4. Jackpot Contribution Mechanism: The ETGT may be configured to automatically calculate and transmit the appropriate percentage of each side bet to the JMS for addition to the jackpot pool.
5. Mystery Trigger Integration: The ETGT may be capable of receiving and acting upon jackpot trigger signals from the JMS, interrupting normal game play to announce and award jackpots when triggered.
6. Multi-Game Compatibility: The side bet and jackpot system may be designed to work seamlessly across different table game types, potentially with game-specific side bet amounts or contribution rates.

These implementation details enable the innovative concept to be deployed in live dealer electronic game table systems and DETGs by creating a flexible, game-agnostic jackpot system that enhances the excitement of table games without altering their specific mechanics. This approach is differentiated from conventional ETGTs and EGMs of the prior art by its focus on side bets for jackpot funding, allowing players to opt-in to the jackpot feature without affecting the base game's house edge or payout structure.

Example Walk-through Scenario: Let's walk through an example of how this side bet-driven mystery jackpot may play out:
1. The Jackpot Management System initializes the mystery jackpot at $10,000 with a hidden trigger point set randomly between $15,000 and $25,000.
2. Player A approaches a DETG blackjack table and places a $10 main bet and a $1 jackpot side bet. The ETGT immediately transmits the $1 side bet information to the JMS.
3. The JMS adds 90 cents (90% of the side bet) to the jackpot pool, increasing it to $10,000.90. The jackpot displays on all connected ETGTs update accordingly.
4. Over the next hour, players at various DETGs (blackjack, baccarat, and roulette) continue to place jackpot side bets, steadily increasing the jackpot amount.
5. Player B sits down at a DETG baccarat table when the displayed jackpot amount is $17,532.40. They place a $25 main bet on Player and a $5 jackpot side bet.
6. As the JMS processes Player B's side bet, it determines that the new jackpot total of $17,536.90 has exceeded the pre-set mystery trigger point of $17,535.50.
7. The JMS immediately sends a jackpot win signal to all connected ETGTs, with specific information sent to Player B's terminal.
8. All ETGTs briefly interrupt their games to announce the jackpot win. Player B's terminal displays a celebratory animation and informs them that they've won the $17,536.90 jackpot.
9. The baccarat dealer at Player B's table is notified via their interface, and casino staff are alerted to verify the win and initiate the payout process.
10. Once the win is verified and paid, the JMS resets the jackpot to its starting value and randomly selects a new trigger point, beginning the cycle anew.

This scenario demonstrates how the system creates ongoing excitement and engagement through the side bet mechanism, while the mystery trigger adds an element of surprise to jackpot wins.

Player Interaction: Players interact with this system primarily through the jackpot side bet option on the ETGT interface. Here's how a typical player experience may unfold:
1. The player approaches a DETG and observes the current jackpot amount prominently displayed.
2. After sitting down, the player logs in using their player card or enters their details on the ETGT interface.
3. When placing their main game wager, the player is presented with the option to place a jackpot side bet. The interface clearly shows the cost of the side bet and any game-specific rules.
4. If the player chooses to place the side bet, they see an immediate animation confirming their participation in the jackpot.
5. Throughout their play session, the player may watch the jackpot amount increase in real-time, creating a sense of anticipation.
6. If a jackpot is won (either by the player or someone else), the player experiences a brief but exciting interruption to their game as the win is announced.
7. If they are the lucky winner, they are guided through the verification and payout process by both the ETGT interface and casino staff.

This interaction is novel for DETGs as it allows players to directly opt into a jackpot feature, similar to slot machines, while maintaining the specific table game experience. It adds an extra layer of excitement and decision-making to each hand or spin.

### Distinguishing Innovative Concepts:

1. Game-Agnostic Side Bet System: This concept allows for a unified jackpot across multiple table game types, each potentially with different side bet amounts or contribution rates, creating a cohesive experience across the casino floor.
2. Transparent Jackpot Funding: Unlike many mystery jackpot systems where funding is opaque to players, this system clearly shows how player side bets directly contribute to the jackpot growth.
3. Opt-In Jackpot Participation: By using a side bet mechanism, players may choose whether to participate in the jackpot on a per-hand or per-spin basis, providing more control over their gaming experience.
4. Dynamic Contribution Rates: The system may adjust the percentage of each side bet that goes to the jackpot based on current jackpot size, time of day, or other factors to optimize excitement and jackpot growth rates.
5. Integrated Live Dealer Compatibility: The side bet system is designed to work seamlessly with both fully electronic and live dealer hybrid games, requiring careful integration to not disrupt the flow of live-dealt games.

These concepts differentiate the ETGT from conventional EGMs by creating a more transparent and flexible jackpot system specifically tailored to the unique characteristics of table games.

### Distinguishing Inventive Steps:

1. Multi-Game Side Bet Normalization: The system implements a novel algorithm to normalize side bets across different game types with varying bet limits and play speeds, ensuring fair jackpot contribution and win probability for all players.
2. Dynamic Mystery Trigger Adjustment: The system continuously adjusts the range for the mystery trigger point based on current player volume, jackpot size, and historical data to maintain optimal win frequency and jackpot sizes.
3. Integrated Dealer Notification System: For live dealer games, the system includes a specialized interface that notifies dealers of jackpot side bets and wins without disrupting game flow, a unique challenge not present in fully electronic games.

These steps address the specific challenges of integrating a side bet-driven jackpot into diverse table games with varying rules and paces. They enable a unified jackpot experience across different game types while respecting the unique characteristics of each game, which is not possible with conventional EGMs designed for single-game jackpots.

35 USC 101 Considerations: The technical implementation of this Innovative Concept is patentable subject matter under 35 USC 101 for several reasons:
(a) This concept goes beyond a mere abstract idea by capturing a specific improvement over prior art in the field of electronic table games. It solves the technical challenge of implementing a flexible, opt-in jackpot system across diverse table games, which was previously not feasible due to the varying rules, paces, and betting structures of different table games.
(b) The innovative concept is directed to an improvement in computer functionality which solves a problem in an existing technological process. Specifically, it addresses the challenge of real-time side bet tracking, normalization across game types, and dynamic jackpot management in a distributed network of heterogeneous game types. This may require novel solutions for data synchronization, real-time financial calculations, and seamless integration with both electronic and live dealer games.
(c) The concept integrates the improvement into a practical application which enables a discernible advancement in computer functionality. It creates a new type of networked gaming system that may manage complex, real-time financial transactions across multiple game types while maintaining game integrity and providing a unified player experience. This practical application enhances the functionality of electronic table games, creating new possibilities for player engagement and casino operations.

The implementation may require specific hardware configurations and software algorithms that go beyond generic computer components, including specialized interfaces for side bet input, advanced algorithms for multi-game normalization, and real-time distributed financial processing. These technical elements transform the abstract idea of a side bet-driven jackpot into a concrete, technological improvement in the field of electronic gaming.

Data Input: The system may require various types of data inputs from players and other casino systems:
1. Side Bet Information: When a player places a jackpot side bet, the ETGT must capture the bet amount and timestamp.
2. Player Identification: If the jackpot system is tied to a player tracking system, player ID information may be input for each side bet.
3. Game Type and State: The system must know which game type each side bet is associated with and the current state of the game (e.g., betting open, game in progress).
4. Dealer Input: For live dealer games, the system may require input from the dealer to confirm side bets or trigger jackpot announcements.
5. Casino Configuration Data: Input from casino management regarding starting jackpot amounts, contribution rates, and trigger ranges.

These data inputs enable the system to accurately track and manage side bets across multiple game types, a notable novel feature of this DETG jackpot system.

### Component Interactions and Procedural Steps:

1. ETGT to Table Game Server:
   Transmits each jackpot side bet placed
   Reports game state changes
   Receives jackpot updates and win notifications
2. Table Game Server to Jackpot Management System:
   Forwards aggregated side bet data
   Requests current jackpot amount updates
   Receives jackpot win signals
3. Jackpot Management System to RNG:
   Requests random numbers for setting mystery trigger points and selecting winners
4. Jackpot Management System to CMS:
   Reports jackpot status and win events
   Receives configuration updates
5. Jackpot Management System to Player Tracking System:
   Verifies player eligibility for jackpot participation
   Updates player accounts with side bet activity and wins
6. Jackpot Management System to Accounting System:
   Reports all financial transactions related to side bets and jackpot payouts Notable novel steps in this flow include:
Real-time normalization of side bets across different game types
Dynamic calculation of jackpot growth and trigger points based on side bet volume
Seamless integration of jackpot mechanics into diverse game types without disrupting specific gameplay

These interactions and steps are unique to DETGs and live dealer systems as they must handle the complexities of various table game types while maintaining a cohesive, exciting jackpot experience.

Data Processing: The system performs several notable processing steps:
1. Side Bet Normalization: The JMS must process incoming side bets from different game types, normalizing their contribution to the jackpot based on game-specific factors.
2. Jackpot Growth Calculation: The system continuously recalculates the current jackpot amount based on incoming side bets.
3. Mystery Trigger Evaluation: With each side bet, the system evaluates whether the new jackpot total has reached the pre-set trigger point.
4. Winner Selection: When the trigger point is reached, the system must instantly select a winner from all eligible players who placed a side bet on that round.
5. Contribution Rate Adjustment: The system may dynamically adjust the percentage of each side bet that goes to the jackpot based on current conditions.

These processing steps are novel in their application to table games, requiring complex real-time calculations across diverse game types.

Outputs and Responses: The system provides various outputs and responses:
1. To Players:
   Real-time jackpot amount updates on ETGT displays
   Confirmations of side bet placement
   Jackpot win announcements and celebrations
2. To Dealers:
   Notifications of jackpot side bets placed
   Instructions for handling jackpot wins during live games
3. To Casino Management:
   Real-time reports on side bet volume and jackpot status
   Alerts for unusual betting patterns or system issues
   Jackpot win verifications and payout instructions

These outputs create a dynamic, transparent jackpot experience unique to this DETG system, enhancing player engagement beyond what's possible with conventional EGMs.

Data Storage and Reporting: The system stores and reports various data types:
1. Side Bet History: Detailed records of all jackpot side bets, including amounts, timestamps, and associated game types.
2. Jackpot History: A complete record of jackpot amounts, trigger events, and winners.
3. Game Performance Metrics: Data on how the side bet jackpot system affects player behavior and game performance across different game types.

This data is notable for regulatory compliance, game optimization, and creating personalized player experiences unique to this DETG jackpot system.

End of Interaction: When a jackpot is awarded, the system:
1. Freezes the jackpot amount on all displays
2. Notifies all ETGTs of the win, triggering celebratory animations
3. Initiates the winner verification and payout process
4. Resets the jackpot to its starting value
5. Selects a new mystery trigger point
6. Logs all details of the winning event for auditing and reporting purposes
7. Resumes normal operation, beginning a new cycle of jackpot accumulation

This end-of-cycle process is unique to this DETG system as it must coordinate the reset across multiple game types simultaneously, ensuring a seamless transition back to normal play for all connected tables.

### Innovative Concept 3—Time-Based Jackpot Activation Windows

Identification of Concept: This innovative concept introduces randomized windows of time where the mystery jackpot feature is enabled, driving player engagement during specific periods. The system creates unpredictable “hot zones” where the chance of winning a jackpot is activated, adding an element of excitement and urgency to the live dealer electronic game table systems (DETG). This concept may be implemented across multiple networked DETGs, creating a casino-wide atmosphere of anticipation. The time-based activation windows are dynamically generated using sophisticated algorithms that consider factors such as current player engagement levels, time of day, and overall casino activity. This approach differs from traditional static jackpot systems by introducing a temporal element that may be used to strategically boost player participation during typically slower periods or enhance excitement during peak hours.

### Sequence Diagram Components:

1. ELECTRONIC TABLE GAME TERMINAL (ETGT): The primary interface for players, displaying game information and jackpot status.
2. Player A, Player B: Individual players participating in the game.
3. Dealer Interface: The live dealer's control panel for managing the game.
4. Central Jackpot Server: Manages the jackpot pool and activation windows.
5. Time Window Generator: Algorithmic component for creating random activation periods.
6. Player Tracking System: Monitors player activity and engagement levels.
7. Casino Management System: Oversees overall casino operations and strategies.
8. Jackpot Display System: Large screens displaying jackpot information across the casino floor.

Implementation Details: The ELECTRONIC TABLE GAME TERMINAL is configured with a specialized jackpot module that interfaces with the Central Jackpot Server. This module continuously listens for activation signals from the server, which are triggered by the Time Window Generator. The ETGT's user interface is designed with a dynamic jackpot display area that may instantly switch between an inactive and active state, visually alerting players when a jackpot window opens.

The Time Window Generator utilizes a combination of pseudo-random number generation and weighted probabilities based on historical data. It considers factors such as time of day, day of the week, and season to create a distribution of activation windows that aligns with the casino's strategic goals. For example, it may increase the frequency of windows during traditionally slow periods to boost engagement.

The system also incorporates real-time data from the Player Tracking System to adjust window frequencies based on current floor activity. If engagement is low, the system may trigger more frequent or longer activation windows to stimulate play. Conversely, during peak times, the windows may be shorter but offer larger jackpots.

A notable innovative aspect is the integration of the live dealer into the jackpot activation process. The Dealer Interface is equipped with a discreet notification system that alerts the dealer just before a jackpot window is about to open. This allows the dealer to build anticipation verbally, adding a human element to the digital system.

Example Walk-through Scenario: It's a Tuesday evening, typically a slower time for the casino. The Time Window Generator, considering this factor, has increased the probability of jackpot windows. At 8:45 PM, it triggers a 15-minute activation window.

The Central Jackpot Server immediately sends signals to all connected ETGTs. On each terminal, the jackpot display area animates to life, showing “Jackpot Active!” along with a countdown timer. Simultaneously, the large Jackpot Display Systems around the casino floor light up, creating a buzz of excitement.

Players A and B, who were casually playing, notice the change on their screens. The dealer, having received a notification through their interface, announces, “Ladies and gentlemen, the jackpot is now active for the next 15 minutes! Every hand played during this time has a chance to win big!”

As the window progresses, the Player Tracking System notices an uptick in player engagement, with more bets being placed and new players joining tables. This data is fed back to the Casino Management System, which logs it for future analysis and strategy adjustment.

At 8:59 PM, with one minute left in the window, tension peaks. Player A wins a hand with a specific combination that triggers the jackpot. The ETGT immediately notifies the Central Jackpot Server, which verifies the win and instructs all connected systems to update their displays, showing the winning amount and location.

As the window closes, the system resets, but the increased engagement often continues beyond the activation period, demonstrating the concept's effectiveness in boosting overall play.

Player Interaction: Players interact with this concept primarily through their individual ETGTs. When a jackpot window activates, their screen undergoes a noticeable but non-disruptive transformation. A previously subdued jackpot display area becomes prominent, showing the active status, current jackpot amount, and a countdown timer.

Players may choose to increase their bets or play more hands during these periods to maximize their chances of winning. The system may offer a “Jackpot Bet” option that becomes available only during active windows, allowing players to place an additional wager specifically for the jackpot.

The live dealer plays a notable role in player interaction. They may verbally announce the opening of a jackpot window, building excitement and encouraging participation. They may also provide commentary on near-misses or the time remaining, adding a human touch to the digital experience.

Players also interact indirectly through their general play patterns. The Player Tracking System monitors these patterns, which in turn influence future activation windows. This creates a dynamic where increased play during jackpot windows may lead to more frequent or longer windows in the future, rewarding active players.

### Distinguishing Innovative Concepts:

1. Dynamic Time-Based Activation: Unlike static jackpot systems, this concept introduces a temporal element that creates urgency and excitement.
2. Integrated Live Dealer Involvement: The system uniquely combines digital randomization with human interaction, allowing dealers to build anticipation and excitement.
3. Adaptive Window Generation: The Time Window Generator's use of historical data and real-time player engagement levels to adjust window frequency and duration is a novel approach to jackpot management.
4. Cross-ETGT Synchronization: The ability to activate jackpot windows across multiple tables simultaneously creates a casino-wide event atmosphere.
5. Player Engagement Feedback Loop: The system's use of real-time player data to influence future window generation creates a responsive, evolving jackpot experience.

### Distinguishing Inventive Steps:

1. Algorithmic Window Generation: The Time Window Generator uses a complex algorithm that considers multiple factors (time, day, season, current engagement levels) to create unpredictable yet strategically timed activation windows.
2. Real-Time Dealer Notification: The system notifies dealers just before a window opens, allowing them to prepare and build anticipation among players.
3. Dynamic ETGT Interface Transformation: The ETGT's ability to instantly switch between inactive and active jackpot states, including visual and potentially audio cues, creates a more immersive experience.

35 USC 101 Considerations: This innovative concept goes beyond a mere abstract idea by implementing a specific, technical solution to the problem of maintaining player engagement in electronic table games. It captures a tangible improvement over prior art by introducing a dynamic, time-based element to jackpot systems that was not previously possible.

The concept is directed at improving computer functionality in the context of electronic gaming systems. It solves the technological problem of static, predictable jackpot systems by introducing a complex, adaptive algorithm that generates activation windows based on multiple real-time inputs. This represents a clear advancement in the field of electronic gaming technology.

The improvement is integrated into a practical application through the synchronized network of ETGTs, central servers, and display systems. The real-time nature of the window generation and activation, coupled with the immediate response across multiple networked devices, demonstrates a discernible advancement in computer functionality within the gaming industry.

Furthermore, the system's ability to adapt based on player behavior creates a feedback loop that continuously improves its effectiveness, illustrating a level of machine learning and adaptability that goes beyond traditional gaming systems.

Data Input: The system may require various data inputs to function effectively:
1. Player Activity Data: Gathered from individual ETGTs, including bet amounts, frequency of play, and duration of sessions.
2. Time and Date Information: Desirable for the Time Window Generator's calculations.
3. Historical Casino Data: Past patterns of player engagement and jackpot activations.
4. Dealer Inputs: Potentially allowing dealers to provide feedback or trigger special events through their interface.
5. Casino Management Inputs: Allowing for manual adjustments to window frequencies or jackpot amounts based on strategic decisions.
6. Real-Time Casino Floor Data: Overall activity levels, number of active tables, etc.

This diverse range of inputs allows for a more sophisticated and responsive system compared to traditional jackpot setups, enabling the creation of a dynamic and engaging player experience unique to DETGs.

### Component Interactions and Procedural Steps:

1. Time Window Generation:
   The Time Window Generator continuously analyzes inputs from the Casino Management System and Player Tracking System.
   It uses this data to calculate the next activation window, considering factors like current floor activity and historical patterns.
   Once a window is determined, it notifies the Central Jackpot Server.
2. Jackpot Activation:
   The Central Jackpot Server receives the activation signal and prepares for the window opening.
   Moments before activation, it sends a notification to the Dealer Interface.
   At the designated time, it broadcasts the activation signal to all connected ETGTs and the Jackpot Display System.
3. ETGT Response:
   Upon receiving the activation signal, each ETGT's jackpot module triggers a UI update.
   The jackpot display area becomes prominent, showing the active status and countdown.
   The module may enable special “Jackpot Bet” options for players.
4. Player Engagement:
   As players interact with the ETGTs during the active window, their actions are logged by the Player Tracking System.
   This data is continuously fed back to the Central Jackpot Server and Time Window Generator for real-time analysis.
5. Jackpot Win Processing:
   If a jackpot is won, the ETGT immediately notifies the Central Jackpot Server.
   The server verifies the win, updates the jackpot amount, and broadcasts the result to all connected systems.
6. Window Closure:
   At the end of the activation period, the Central Jackpot Server signals all systems to return to the normal state.
   The Time Window Generator begins calculating the next activation window based on the most recent data.

This procedural flow showcases the complex interactions between multiple systems, highlighting the innovative approach to creating a dynamic, responsive jackpot experience in the DETG environment.

Data Processing: The system processes data through several notable steps:
1. Window Probability Calculation: The Time Window Generator processes historical and real-time data to calculate the optimal timing and duration for activation windows.
2. Player Engagement Analysis: Real-time data from ETGTs is processed to determine current engagement levels, influencing both ongoing and future window generations.
3. Jackpot Amount Computation: The system continuously updates the jackpot amount based on player activity and predefined increment rules.
4. Win Verification: When a potential win occurs, the system rapidly processes the game outcome against the active jackpot criteria to confirm the win.
5. Performance Metrics Calculation: The system regularly processes data to generate metrics on the effectiveness of different window patterns, informing future strategies.

This sophisticated data processing enables a level of dynamism and responsiveness in jackpot management that is uniquely suited to the DETG environment.

Outputs and Responses: The system provides various outputs and responses:
1. Visual Jackpot Activation: ETGTs and large displays visually indicate when a jackpot window is active.
2. Real-Time Jackpot Amount Updates: All displays are continuously updated with the current jackpot amount.
3. Dealer Notifications: Discreet alerts are sent to dealer interfaces before and during activation windows.
4. Win Announcements: When a jackpot is won, the system generates casino-wide notifications.
5. Player-Specific Messages: ETGTs may display personalized messages encouraging participation during active windows.
6. Management Reports: The Casino Management System receives regular reports on jackpot performance and player engagement metrics.

These outputs create a comprehensive and engaging jackpot experience that spans from individual player interactions to casino-wide events.

Data Storage and Reporting: The system stores various data points:
1. Activation Window History: Timing, duration, and effectiveness of past windows.
2. Player Engagement Metrics: Correlated with jackpot windows.
3. Jackpot Win Data: Amounts, timing, and associated player information.
4. System Performance Logs: For troubleshooting and optimization.

Regular reports are generated for casino management, including trend analysis and recommendations for future jackpot strategies.

End of Interaction: As each jackpot window closes, the system seamlessly transitions back to its base state. ETGTs update their interfaces, removing the prominent jackpot displays. The Time Window Generator immediately begins calculating the next activation window based on the most recent data, ensuring the cycle of engagement continues. This smooth transition maintains the flow of regular gameplay while keeping players anticipating the next exciting jackpot opportunity.

### Innovative Concept 4—Location-Based Jackpot Trigger

Identification of Concept: This innovative concept introduces a jackpot that may be triggered based on the number of players at specific physical or online locations. The system monitors player activity across multiple Dealer-controlled Electronic Table Games (DETGs) in various locations, such as different areas within a casino or even across multiple casinos. The jackpot is activated when a predetermined number of players are actively engaged in gameplay at specified locations. For example, the jackpot may trigger when 50 players are active at Casino A and 100 players at Casino B simultaneously. This concept creates a unique, collaborative atmosphere among players and encourages increased participation across multiple gaming sites. It leverages the networked nature of modern casino systems to create a more expansive and engaging jackpot experience that transcends individual game tables or casino boundaries.

### Sequence Diagram Components:

1. ELECTRONIC TABLE GAME TERMINAL (ETGT): The primary interface for players, displaying game information and jackpot status.
2. Player A, Player B: Individual players participating in the game at different locations.
3. Dealer Interface: The live dealer's control panel for managing the game.
4. Central Jackpot Server: Manages the jackpot pool and monitors player counts across locations.
5. Location Tracking Module: Tracks and reports the number of active players at each location.
6. Casino Management System: Oversees overall casino operations and strategies.
7. Inter-Casino Network: Facilitates communication between different casino locations.
8. Jackpot Display System: Large screens displaying jackpot information and player counts across locations.

Implementation Details: The ELECTRONIC TABLE GAME TERMINAL is equipped with a specialized location-aware module that communicates with the Central Jackpot Server. This module regularly sends heartbeat signals to confirm active gameplay and the player's location. The ETGT's interface includes a dynamic display showing current player counts at various locations, creating a sense of community and shared purpose among players.

The Location Tracking Module is a notable component that aggregates data from all ETGTs across different locations. It uses a combination of GPS data (for mobile devices), IP geolocation (for online players), and physical terminal locations to accurately track player distribution. This module employs advanced algorithms to handle edge cases, such as players moving between areas or temporary connection losses.

The Central Jackpot Server continuously monitors the data from the Location Tracking Module. It uses predefined thresholds for each location to determine when jackpot conditions are met. These thresholds may be dynamically adjusted based on historical data, time of day, or special events to maintain optimal engagement levels.

A notable innovation is the Inter-Casino Network, which allows for real-time communication and synchronization between different casino locations. This network ensures that player counts and jackpot statuses are consistently updated across all participating venues, creating a truly interconnected gaming experience.

The system also incorporates a failsafe mechanism to handle sudden fluctuations in player counts. If a location experiences a sudden drop in players (e.g., due to technical issues), the system may temporarily adjust thresholds to maintain jackpot eligibility, ensuring fairness and continued excitement.

Example Walk-through Scenario: It's a Friday evening, and the casino network has set a jackpot trigger condition of 50 players at Casino A and 100 players at Casino B. The Jackpot Display Systems at both locations show real-time player counts: Casino A has 45 active players, while Casino B has 92.

As more players join the games, the displays update in real-time. The atmosphere becomes more excited as the numbers climb closer to the threshold. Dealers at both locations, notified through their interfaces, start encouraging more players to join, highlighting the growing jackpot amount.

At 9:30 PM, Casino A reaches 50 players. The system notifies all ETGTs and display screens, showing that one location has met its threshold. This creates a surge of activity at Casino B as players rush to push their count over 100.

At 9:35 PM, Casino B hits 100 players. Instantly, the Central Jackpot Server recognizes that both conditions are met. It triggers the jackpot state across all connected ETGTs and display systems. All eligible players now have a chance to win the jackpot on their next hand.

Player A at Casino A and Player B at Casino B, both playing at that moment, feel the excitement of being part of this multi-location event. The dealers announce the active jackpot state, adding to the thrill.

At 9:37 PM, Player A wins a hand with a specific combination that triggers the jackpot. The system verifies the win, updates all displays across both casinos, and initiates the payout process. Players at both locations celebrate the win, feeling part of a larger gaming community.

Player Interaction: Players interact with this concept through their ETGTs and the ambient information provided by the large display systems. Each ETGT shows a mini-map or dashboard indicating player counts at various locations. As counts approach trigger thresholds, this display becomes more prominent, creating anticipation.

Players may see how their participation contributes to the overall count, fostering a sense of community and shared purpose. They may be encouraged to invite friends to join or to try tables at different locations to help meet thresholds.

The live dealers play a notable role in building excitement. They may announce when locations are close to their thresholds, encouraging more players to join. This human element adds to the digital experience, making players feel part of a larger event.

Players also interact indirectly through their continued gameplay. The system tracks not just presence but active play, so players are incentivized to keep engaging with the games to maintain the player count at their location.

### Distinguishing Innovative Concepts:

1. Multi-Location Synchronized Jackpot: This concept uniquely ties together player activity across multiple physical and potentially online locations.
2. Dynamic Player Count Thresholds: The system may adjust trigger conditions based on historical data and current casino strategies.
3. Real-Time Visual Feedback: Players may see their contribution to the overall goal, creating a more engaging and community-oriented experience.
4. Cross-Casino Collaboration: The concept encourages cooperation between different casino properties, potentially even competitors, to create larger, more exciting jackpots.
5. Adaptive Failsafe Mechanisms: The system may adjust to unexpected changes in player counts, ensuring fairness and maintaining excitement.

### Distinguishing Inventive Steps:

1. Location-Aware Player Tracking: The system accurately tracks and categorizes players by location while handling edge cases like player movement.
2. Multi-Site Threshold Synchronization: The Central Jackpot Server coordinates complex trigger conditions across multiple locations in real-time.
3. Integrated Inter-Casino Communication: The system facilitates seamless data sharing and jackpot management across different casino properties.

35 USC 101 Considerations: This innovative concept transcends a mere abstract idea by implementing a concrete, technical solution to the challenge of creating engaging, multi-location jackpot experiences. It represents a significant improvement over prior art by introducing a sophisticated, networked approach to jackpot triggering that was not previously feasible.

The concept directly addresses the technological problem of engaging players across multiple physical and virtual locations in a unified gaming experience. It does so through a complex system of real-time player tracking, data aggregation, and cross-location communication, representing a clear advancement in casino gaming technology.

The improvement is integrated into a practical application through the network of ETGTs, location tracking modules, and inter-casino communication systems. The real-time nature of the player counting, threshold monitoring, and jackpot triggering across multiple locations demonstrates a tangible advancement in computer functionality within the gaming industry.

Moreover, the system's ability to adapt to changing conditions and handle complex multi-site scenarios showcases a level of sophistication that goes beyond traditional gaming systems, firmly placing it in the realm of patentable subject matter under 35 USC 101.

Data Input: The system may require various data inputs to function effectively:
1. Player Location Data: Gathered from ETGTs, including GPS coordinates, IP addresses, or physical terminal locations.
2. Active Gameplay Data: Information on whether a player is actively participating, not just present.
3. Historical Location Data: Past patterns of player distribution and activity across locations.
4. Casino Configuration Data: Information on participating locations and their current threshold settings.
5. Dealer Inputs: Allowing dealers to provide feedback or trigger special location-based events.
6. Casino Management Inputs: Enabling manual adjustments to thresholds or jackpot conditions based on strategic decisions.

This diverse range of inputs allows for a sophisticated and responsive system that may create a dynamic, multi-location jackpot experience unique to networked DETGs.

### Component Interactions and Procedural Steps:

1. Player Location Tracking:
   Each ETGT regularly sends location and activity data to the Location Tracking Module.
   The module aggregates this data and categorizes players by location.
2. Threshold Monitoring:
   The Central Jackpot Server continuously receives updated player counts from the Location Tracking Module.
   It compares these counts against the predefined thresholds for each location.
3. Inter-Casino Communication:
   The Inter-Casino Network facilitates real-time data sharing between different casino locations.
   It ensures that player counts and jackpot statuses are synchronized across all participating venues.
4. Jackpot Activation:
   When all location thresholds are met, the Central Jackpot Server triggers the jackpot state.
   It broadcasts this state change to all connected ETGTs, Dealer Interfaces, and Jackpot Display Systems.
5. ETGT Response:
   Upon receiving the jackpot activation signal, each ETGT updates its interface to show the active jackpot state.
   Special jackpot betting options may be enabled.
6. Jackpot Win Processing:
   If a jackpot is won, the ETGT immediately notifies the Central Jackpot Server.
   The server verifies the win and broadcasts the result to all connected systems across all locations.
7. System Adaptation:
   The Location Tracking Module continuously monitors for sudden changes in player counts.
   If significant fluctuations occur, it notifies the Central Jackpot Server, which may adjust thresholds temporarily.

This procedural flow demonstrates the complex interactions between multiple systems across different locations, highlighting the innovative approach to creating a dynamic, multi-site jackpot experience in the DETG environment.

Data Processing: The system processes data through several notable steps:
1. Location Data Aggregation: The Location Tracking Module continuously processes incoming location data to maintain accurate player counts.
2. Threshold Calculation: The system regularly recalculates optimal threshold levels based on historical data and current casino strategies.
3. Real-Time Count Comparison: Constant comparison of current player counts against thresholds to determine jackpot eligibility.
4. Cross-Location Data Synchronization: Ensuring consistent player count and jackpot information across all participating locations.
5. Anomaly Detection: Processing player count data to identify and respond to unusual fluctuations.

This sophisticated data processing enables a level of multi-location coordination and responsiveness in jackpot management that is uniquely suited to networked DETG environments.

Outputs and Responses: The system provides various outputs and responses:
1. Real-Time Player Count Displays: ETGTs and large displays show current counts for each location.
2. Threshold Proximity Alerts: Visual and audio cues when locations approach their player count thresholds.
3. Jackpot Activation Notifications: Casino-wide alerts when the jackpot becomes active.
4. Dealer Updates: Information sent to Dealer Interfaces about current counts and jackpot status.
5. Inter-Casino Notifications: Updates shared between participating casinos about collective progress towards jackpot activation.
6. Management Reports: Detailed analytics on player distribution and jackpot performance across locations.

These outputs create a comprehensive and engaging multi-location jackpot experience that spans from individual player interactions to casino-wide and even multi-casino events.

Data Storage and Reporting: The system stores various data points:
1. Historical Player Count Data: Trends in player distribution across locations over time.
2. Jackpot Activation History: Timing and frequency of threshold achievements and jackpot triggers.
3. Location-Specific Performance Metrics: How different sites contribute to and benefit from the shared jackpot system.
4. System Communication Logs: For troubleshooting and optimizing the inter-casino network.

Regular reports are generated for casino management, including insights on player behavior across locations and recommendations for optimizing the multi-site jackpot strategy.

End of Interaction: As a jackpot is won or the gaming session ends, the system smoothly transitions back to its base state. ETGTs update their interfaces, resetting player count displays. The Location Tracking Module continues monitoring player distributions, and the Central Jackpot Server begins preparing for the next multi-location jackpot event. This seamless transition maintains the excitement of the shared gaming experience while setting the stage for future collaborative jackpot opportunities across the network of casinos.

### Innovative Concept 6—Cumulative Sequential Player Participation

### Identification of Concept:

The innovative concept of Cumulative Sequential Player Participation introduces a mystery jackpot system that is triggered once a predetermined number of players participate sequentially at a Dealer-controlled Electronic Table Game (DETG). The notable innovation here is that the jackpot is not tied to specific gameplay outcomes but rather to the cumulative participation of players over a series of game sessions. This concept leverages player volume and engagement, progressively increasing the jackpot with each new player participating at the DETG terminals. As more players engage in the DETG game, the jackpot nears its triggering point, encouraging players to stay longer and drive player retention.

### Sequence Diagram Components:

1. Electronic Table Game Terminal (ETGT): Each player's interface for participating in the DETG game.
2. Player A, Player B, etc.: Individual players who contribute to the sequential participation.
3. Game Server: Manages game outcomes, collects player participation data, and tracks the sequential player participation count.
4. Casino Network: Facilitates data exchange between ETGTs, game server, and jackpot systems.
5. Jackpot Pool System: Aggregates contributions from each player session and tracks jackpot progression.
6. Player Tracking System: Monitors player participation and ensures proper credit for sequential player engagement.
7. Live Dealer: Oversees game sessions, ensuring smooth progression between players.

### Implementation Details:

The Cumulative Sequential Player Participation concept may be implemented by configuring the DETG terminals to automatically track player participation through integrated player-tracking systems or the casino's loyalty systems. Each time a player completes a game round, their participation is logged by the Game Server, which checks the sequential order of players. Once the predefined number of players have participated consecutively without interruption, the system triggers the mystery jackpot.

The Game Server communicates with the Casino Network to ensure real-time updates of participation counts. Each player's ETGT records their entry, transmitting data to the Jackpot Pool System, which increases the jackpot pool for every new player added to the sequence. This pool progressively builds until the preset participation threshold is reached, triggering a jackpot event.

This implementation encourages sustained player engagement as they contribute to a common goal of unlocking the jackpot. The system may include an interface displaying how many players are left before the jackpot is triggered, generating excitement and encouraging more players to join or continue participating.

### Example Walk-Through Scenario:

A scenario begins with Player A sitting at an ETGT within a live casino environment and joining a DETG session. After completing a round of baccarat, their participation is recorded by the Game Server. Player B follows immediately and also participates, with their participation logged as well. The Casino Network ensures both players' actions are communicated back to the jackpot pool system, which updates the participation counter.

The game continues with Player C, Player D, and so on, until the participation count reaches the predefined threshold, such as 50 consecutive players. When Player 50 completes their round, the jackpot pool reaches the triggering point, and the system activates a jackpot award sequence.

At this moment, the Game Server signals the jackpot pool system to display a winning jackpot animation on all connected ETGTs, and the winning player or players (depending on the jackpot distribution model) are credited with their respective portions of the jackpot.

### Player Interaction:

Each player engages by simply participating in consecutive rounds of the DETG game. They do not need to make any special side bets or perform additional actions to qualify for the jackpot. As each player completes their round, they contribute to the cumulative participation threshold, which is dynamically tracked and displayed on the ETGT. This creates a sense of anticipation among all players, as each new round brings them closer to a jackpot event. Player interaction remains streamlined and focused on gameplay, with the jackpot event adding an extra layer of excitement and reward potential.

### Distinguishing Innovative Concepts:

This innovative concept differentiates itself from conventional ETGTs by introducing a community-driven jackpot mechanism that focuses on sequential participation rather than gameplay outcomes. One aspect of novelty lies in its ability to harness the flow of multiple players through a DETG system, aggregating their participation toward a common reward. Unlike prior art, which typically relies on individual achievements or specific game results to trigger jackpots, this concept rewards collective player involvement, enhancing the social and communal aspects of DETG play. This participatory structure, coupled with the flexibility of integrating various games like baccarat or blackjack, is unique to this system.

### Distinguishing Inventive Steps:

1. Sequential Participation Tracking: The system tracks each player's participation in consecutive game rounds, ensuring that the jackpot is only triggered when the exact number of players participates in sequence.
2. Real-Time Jackpot Progress Display: A dynamic display on the ETGT terminals shows the current number of participants and the remaining number needed to trigger the jackpot, encouraging players to continue engaging.
3. Community-Based Jackpot Triggering: Unlike individual-based jackpots, this system triggers the jackpot based on cumulative participation, creating a communal incentive for player retention and engagement.

### 35 USC 101 Considerations:

This innovative concept transcends the mere abstract idea of collective participation by providing a technical solution to the challenge of player retention and engagement in DETG environments. The system improves the functionality of traditional DETG systems by implementing real-time sequential player tracking, data processing, and jackpot progression visualization, which solve the technological problem of low player engagement during extended gameplay sessions. Furthermore, this concept integrates these improvements into a practical application that advances DETG technology by fostering a community-oriented gaming environment, thus making it eligible under 35 USC 101.

### Data Input:

Data inputs for this system include player identification, participation logs, and game session information. Each time a player completes a round, the ETGT communicates their participation data to the Game Server via the Casino Network. The system also tracks real-time jackpot contributions and the current participation count.

### Component Interactions and Procedural Steps:

1. ETGT logs player participation after each round.
2. Game Server receives data from each ETGT and updates the sequential participation count.
3. Casino Network facilitates data exchange between the Game Server and Jackpot Pool System.
4. Jackpot Pool System increases the jackpot with each player's participation.
5. ETGT Display updates the current participation count and jackpot status for players.

### Data Processing:

The Game Server processes real-time participation data and computes the cumulative participation required to trigger the jackpot. Each player's action is logged and aggregated, and the system computes whether the participation threshold has been met.

### Outputs and Responses:

Upon reaching the jackpot threshold, the system broadcasts a jackpot win notification to all participating ETGTs. The jackpot amount is distributed among the eligible players, and the jackpot pool is reset for the next cycle.

### Data Storage and Reporting:

Player participation logs, jackpot contributions, and trigger data are stored in the Casino Database for reporting and auditing purposes. This data may also be used for player loyalty programs.

### Error Handling and Security Measures:

The system includes safeguards to ensure that player participation is accurately logged, with security protocols preventing tampering with the participation count or jackpot pool.

### End of Interaction:

Once the jackpot is triggered, the system distributes the winnings and resets the participation counter, readying the DETG system for the next cycle of participation-driven jackpot accumulation.

### Innovative Concept 7—Group Jackpot Sharing

### Identification of Concept:

The Group Jackpot Sharing concept introduces a collaborative jackpot system wherein, when one player wins a jackpot, the players seated adjacent to the winner also receive a share of the jackpot winnings. This inventive feature is designed to enhance player engagement and add a social dimension to the gaming experience. By allowing multiple players to benefit from another player's success, the system fosters a sense of camaraderie and encourages players to stay at the table longer. This concept may be implemented in DETGs, particularly in live dealer-controlled multiplayer games where multiple players participate simultaneously, such as baccarat or blackjack.

### Sequence Diagram Components:

1. Electronic Table Game Terminal (ETGT): Individual terminals where players participate in DETG games.
2. Player A (Winner): The player who triggers the jackpot event.
3. Player B, Player C: Players seated adjacent to Player A who share in the jackpot.
4. Game Server: Manages game data, tracks jackpot triggers, and distributes winnings.
5. Casino Network: Facilitates data transmission between ETGTs and game server.
6. Jackpot Pool System: Accumulates jackpot contributions and redistributes winnings upon trigger events.
7. Live Dealer: Oversees the gameplay and may also trigger certain jackpot-related events.
8. Player Tracking System: Ensures proper allocation of winnings based on player participation.

### Implementation Details:

To implement Group Jackpot Sharing, the DETG system may be configured to recognize which players are seated adjacent to a jackpot winner. The Game Server tracks player positions and identifies the winner once a jackpot is triggered. Simultaneously, the server also identifies the players sitting directly next to the winner on either side, ensuring they receive a share of the winnings.

The Jackpot Pool System dynamically divides the jackpot based on preconfigured rules, such as awarding 50% of the jackpot to the winner and splitting the remaining amount equally among the adjacent players. The Game Server ensures the payouts are distributed accordingly and transmits the appropriate winning amounts back to the respective ETGTs. This implementation allows for seamless distribution without manual intervention from the dealer or casino staff.

### Example Walk-Through Scenario:

Player A is participating in a game of blackjack on an ETGT and places a wager that qualifies for the jackpot. As the game progresses, Player A hits the winning combination that triggers the jackpot. The Game Server immediately recognizes the winning event and identifies the two players seated next to Player A, Player B and Player C, based on their positions at the ETGTs.

Once the jackpot is triggered, the system allocates 50% of the total jackpot to Player A, who triggered the win, and divides the remaining 50% between Player B and Player C. This allocation happens in real-time, and the winnings are displayed on all three players' ETGT screens. The players see a jackpot win notification along with the breakdown of their individual winnings.

### Player Interaction:

Players participate in DETG games as usual without any special actions required to qualify for the group jackpot sharing. The excitement comes from knowing that any player's jackpot win may result in adjacent players also receiving a portion of the winnings. This fosters a collaborative atmosphere at the gaming table, encouraging players to stay seated for longer periods, increasing player retention, and adding excitement as players root for each other's success.

### Distinguishing Innovative Concepts:

The novel aspect of Group Jackpot Sharing lies in its ability to distribute winnings beyond the individual who triggered the jackpot. Traditional jackpot systems only reward the winning player, but this concept uniquely fosters a social gaming experience by allowing adjacent players to share in the success. This mechanism is particularly suited for live dealer-controlled DETGs, where the social interaction and excitement of winning are notable elements of gameplay. Additionally, the dynamic allocation of the jackpot pool across multiple players enhances engagement and retention compared to prior art systems.

### Distinguishing Inventive Steps:

1. Position-Based Jackpot Sharing: When a jackpot is triggered, the system identifies the adjacent players based on their seating positions at the ETGT.
2. Dynamic Payout Allocation: The system automatically allocates the jackpot winnings, ensuring that adjacent players receive their share based on predefined payout rules.
3. Real-Time Notification and Display: The system instantly displays the jackpot win and its distribution across the affected players' ETGTs, enhancing excitement and encouraging continued participation.

### 35 USC 101 Considerations:

The Group Jackpot Sharing system improves the functionality of traditional DETGs by providing a novel method of distributing jackpot winnings among multiple players based on their seating positions. This invention addresses the technical problem of low engagement in multiplayer DETG environments by introducing a social sharing mechanism, which transforms gameplay into a collaborative experience. The integration of player tracking and dynamic jackpot distribution within the ETGT ecosystem goes beyond abstract ideas and is a practical application of advanced gaming network systems, making it eligible under 35 USC 101.

### Data Input:

The primary data inputs include player seating positions, jackpot triggers, and game participation data. The Game Server receives data about player positions and identifies which players are seated adjacent to the jackpot winner.

### Component Interactions and Procedural Steps:

1. ETGT: Each player's position and participation are logged by the system.
2. Game Server: Monitors game progress, recognizes jackpot events, and identifies adjacent players.
3. Jackpot Pool System: Allocates winnings and distributes them across the identified players.
4. Casino Network: Facilitates data exchange between the ETGTs, Game Server, and Jackpot Pool System.
5. Player Tracking System: Ensures accurate allocation of winnings to each player based on participation and position.

### Data Processing:

The Game Server processes player position data and computes the appropriate jackpot distribution. The system identifies the jackpot winner and the adjacent players, allocating the winnings accordingly and updating the jackpot pool in real-time.

### Outputs and Responses:

Once the jackpot is triggered, the system outputs the winning amounts to the relevant players and displays a notification across all connected ETGTs, showing the breakdown of the jackpot.

### Data Storage and Reporting:

The system logs the jackpot event, the players involved, and the winnings distribution for audit purposes. This data is stored in the Casino Database and may be used for loyalty rewards and future promotions.

### Error Handling and Security Measures:

The system includes security protocols to ensure that only the correct players receive their winnings, with checks in place to verify player positions and prevent tampering with the jackpot distribution.

### End of Interaction:

After the jackpot is distributed, the system resets the jackpot pool and prepares for the next round of gameplay, ensuring all player positions and participation data are ready for the next game session.

### Innovative Concept 8—Player-Selectable Jackpot Modes

### Identification of Concept:

The Player-Selectable Jackpot Modes concept allows players to choose between different jackpot participation modes before beginning gameplay. Players may select a “single-winner” mode, where only one player wins the full jackpot, or a “group-sharing” mode, where the jackpot is distributed among multiple players. This feature provides players with a sense of customization and control over their gaming experience, making the DETG environment more interactive and appealing.

### Sequence Diagram Components:

1. Electronic Table Game Terminal (ETGT): The interface where players select their preferred jackpot mode.
2. Player A, Player B, etc.: Players who choose different jackpot modes.
3. Game Server: Records player selections and applies the appropriate jackpot mode during gameplay.
4. Jackpot Pool System: Manages and distributes the jackpot according to the selected modes.
5. Casino Network: Ensures smooth communication between ETGTs, Game Server, and Jackpot Pool System.
6. Live Dealer: Oversees gameplay, ensuring that the selected jackpot modes are applied correctly.

### Implementation Details:

To implement Player-Selectable Jackpot Modes, each ETGT is equipped with an interface allowing players to choose their preferred mode before the start of gameplay. The Game Server records each player's selection and applies the relevant rules for jackpot distribution based on the chosen mode. In the “single-winner” mode, the entire jackpot is awarded to one player, while in the “group-sharing” mode, the jackpot is distributed among a predetermined number of players, such as adjacent players or all players participating in the same game session.

The Jackpot Pool System tracks the contributions and allocates winnings based on the mode selected by the winning player(s). If multiple players select the “group-sharing” mode, the system divides the jackpot among the eligible participants.

### Example Walk-Through Scenario:

Player A begins a game of baccarat at an ETGT and chooses the “single-winner” mode, while Player B chooses the “group-sharing” mode. As the game progresses, Player A triggers the jackpot event. Since Player A selected the “single-winner” mode, the entire jackpot is awarded solely to Player A.

Meanwhile, in another session, Player C chooses the “group-sharing” mode and triggers the jackpot. The Game Server identifies other players who selected the same mode, and the jackpot is distributed equally among them, including Player D and Player E, who also chose “group-sharing.”

### Player Interaction:

Players interact with the DETG by selecting their preferred jackpot mode at the beginning of the session. This added layer of customization makes the gaming experience more interactive, allowing players to tailor their jackpot participation to their preferences.

### Distinguishing Innovative Concepts:

This concept introduces a novel feature that allows players to personalize their jackpot experience. Traditional ETGT systems offer fixed jackpot mechanisms, but this innovative concept allows players to choose between different payout structures, adding flexibility and engagement. This level of customization is particularly appealing in multiplayer DETG environments, where players have different preferences for risk and reward.

### Distinguishing Inventive Steps:

1. Player Mode Selection: Players choose between “single-winner” and “group-sharing” modes before starting gameplay.
2. Dynamic Jackpot Allocation: The system applies the selected mode to determine how the jackpot is distributed upon a winning event.
3. Mode-Specific Notifications: The system provides real-time feedback to players based on their selected jackpot mode, ensuring transparency in how winnings are distributed.

### 35 USC 101 Considerations:

The Player-Selectable Jackpot Modes concept goes beyond the abstract idea of selecting jackpot preferences by integrating it into the technical infrastructure of DETGs. The system solves the problem of player dissatisfaction with fixed jackpot structures by offering dynamic, customizable options. This technical improvement enhances player engagement and adds a practical application that integrates directly into the existing DETG framework, making it patentable subject matter under 35 USC 101.

### Data Input:

Players input their jackpot mode selection at the beginning of the game session. This data is transmitted to the Game Server, which applies the chosen mode during gameplay.

### Component Interactions and Procedural Steps:

1. ETGT: Players input their jackpot mode selection.
2. Game Server: Records the selection and applies the appropriate jackpot rules.
3. Jackpot Pool System: Allocates the jackpot based on the selected mode.
4. Casino Network: Ensures communication between the ETGT, Game Server, and jackpot systems.

### Data Processing:

The Game Server processes each player's mode selection and determines the appropriate jackpot distribution based on the mode triggered by the winning player(s).

### Outputs and Responses:

When a jackpot is triggered, the system outputs the winnings to the relevant player(s) based on the selected mode. The winnings are displayed on the ETGTs, along with a notification of the selected jackpot mode.

### Data Storage and Reporting:

The system logs each player's mode selection and the resulting jackpot distribution for future reference and auditing.

### Error Handling and Security Measures:

The system includes error-checking mechanisms to ensure that the correct jackpot mode is applied and that all players receive the appropriate payouts based on their selections.

### End of Interaction:

At the end of the game session, the system resets the jackpot pool and prepares for the next round of gameplay, ensuring all mode selections are cleared for the next session.

### Innovative Concept 9—VIP Jackpot Multiplier

### Identification of Concept:

The VIP Jackpot Multiplier concept introduces a jackpot system that applies multipliers to a player's jackpot winnings based on their VIP status or engagement with the casino's loyalty rewards system. This inventive feature rewards loyal or high-status players by enhancing their potential jackpot payouts, providing a clear incentive for players to increase their engagement with the casino.

### Sequence Diagram Components:

1. Electronic Table Game Terminal (ETGT): Interface where players place bets and participate in the DETG game.
2. Player A (VIP Player): A player with VIP status participating in the game.
3. Game Server: Tracks player VIP status and applies the appropriate multiplier when the jackpot is triggered.
4. Jackpot Pool System: Calculates the total jackpot winnings, including any applicable multipliers for VIP players.
5. Casino Network: Facilitates data exchange between the ETGT, Game Server, and loyalty systems.
6. Player Tracking System: Monitors and tracks each player's VIP status and loyalty points.

### Implementation Details:

The VIP JackpotMultiplier feature may be implemented by integrating the casino's loyalty system with the DETG game server. Players with VIP status, as determined by their engagement with the casino's rewards system, automatically receive a multiplier on their jackpot winnings. This multiplier may vary based on their VIP tier, ranging from 1.5× to 3×, for example.

The Player Tracking System monitors player activity and updates their VIP status in real-time, ensuring that when a VIP player triggers a jackpot, the Game Server applies the appropriate multiplier. The Jackpot Pool System calculates the total jackpot amount and applies the multiplier before distributing the winnings to the VIP player.

### Example Walk-Through Scenario:

Player A, a VIP player with Platinum status, is participating in a DETG baccarat game. As the game progresses, Player A triggers a jackpot event. The Game Server checks Player A's VIP status through the Player Tracking System and identifies that Player A is eligible for a 2× multiplier on their jackpot winnings due to their Platinum status.

The Jackpot Pool System calculates the jackpot at $50,000 and applies the 2× multiplier, awarding Player A a total of $100,000. This winning amount is immediately displayed on Player A's ETGT, along with a notification indicating the application of the VIP multiplier.

### Player Interaction:

Players interact with the system by participating in DETG games as usual, with their VIP status automatically tracked through the casino's loyalty system. High-status players benefit from the multiplier without needing to take any additional actions, adding excitement and further incentivizing loyalty.

### Distinguishing Innovative Concepts:

The VIP Jackpot Multiplier concept adds a dynamic layer of engagement for loyal or high-status players by directly enhancing their potential rewards. This concept differs from traditional jackpot systems by integrating the casino's loyalty program, thereby providing a tangible benefit for VIP players. The ability to apply multipliers based on VIP status differentiates this system from prior art, where jackpots are typically fixed and do not account for player status.

### Distinguishing Inventive Steps:

1. VIP Status Integration: The system integrates with the casino's loyalty system to track and apply multipliers based on player status.
2. Dynamic Multiplier Application: When a jackpot is triggered, the system dynamically applies the multiplier based on the player's VIP tier.
3. Real-Time Player Status Tracking: The system continuously monitors each player's VIP status to ensure accurate multiplier application during gameplay.

### 35 USC 101 Considerations:

The VIP Jackpot Multiplier concept provides a technical solution to enhancing player engagement by integrating loyalty program data with the DETG game system. This improvement over conventional jackpot systems offers a more personalized gaming experience by dynamically adjusting jackpot rewards based on player status. By linking player status data to the jackpot system in real-time, this innovative concept solves the problem of low engagement among high-value players and enhances the functionality of DETG systems, making it eligible for patentability under 35 USC 101.

### Data Input:

The primary inputs include player VIP status, loyalty points, and game participation data. The Game Server receives this data from the Player Tracking System to apply the correct multiplier.

### Component Interactions and Procedural Steps:

1. ETGT: Players engage in gameplay, and their VIP status is checked upon triggering a jackpot.
2. Game Server: Determines the appropriate multiplier based on the player's VIP status.
3. Jackpot Pool System: Calculates the jackpot amount and applies the multiplier.
4. Player Tracking System: Tracks each player's VIP status and ensures accurate multiplier application.
5. Casino Network: Facilitates data communication between the various system components.

### Data Processing:

The Game Server processes the player's VIP status and applies the relevant multiplier when a jackpot is triggered. The system ensures that the correct multiplier is applied based on the player's current loyalty tier.

### Outputs and Responses:

When a VIP player wins a jackpot, the system applies the multiplier and outputs the winning amount to the player's ETGT. The player receives a notification of the total winnings, including the multiplier effect.

### Data Storage and Reporting:

The system logs the player's VIP status, multiplier application, and total jackpot winnings for audit and reporting purposes. This data is stored in the Casino Database for future analysis and player engagement tracking.

### Error Handling and Security Measures:

The system includes safeguards to ensure that the correct VIP multiplier is applied and that no unauthorized changes are made to a player's VIP status during gameplay.

### End of Interaction:

After the jackpot is awarded, the system resets the multiplier for the next session and updates the player's status in the Player Tracking System for future gameplay interactions.

### Innovative Concept 10—Cross-Game Jackpot Eligibility

### Identification of Concept:

The Cross-Game Jackpot Eligibility concept allows players to qualify for a larger or faster-growing jackpot by playing a series of different games within a given session. This innovative concept encourages players to engage with a variety of DETG games (such as blackjack, baccarat, roulette, or poker) rather than sticking to a single game, thereby increasing overall gameplay activity. By playing multiple games, players build their eligibility toward a mystery jackpot, which may grow more rapidly based on their cross-game participation.

### Sequence Diagram Components:

1. Electronic Table Game Terminal (ETGT): Interfaces where players participate in various DETG games.
2. Player A, Player B, etc.: Players who switch between different DETG games.
3. Game Server: Tracks players' participation across different game types and computes jackpot eligibility.
4. Jackpot Pool System: Aggregates jackpot contributions from different games and adjusts jackpot amounts based on player activity.
5. Casino Network: Manages data communication between the ETGTs, game server, and jackpot pool.
6. Player Tracking System: Monitors players' cross-game participation and updates eligibility status in real-time.

### Implementation Details:

To implement Cross-Game Jackpot Eligibility, DETG terminals and the Game Server are configured to track players' participation across various games. When a player engages in more than one game type (e.g., switching between blackjack and baccarat), the system dynamically adjusts their eligibility for a larger or more rapidly growing jackpot. The Player Tracking System records this participation and communicates it to the Jackpot Pool System, which updates the player's eligibility and increases the potential jackpot amount.

The system encourages players to diversify their gameplay by offering a cumulative jackpot boost or faster jackpot growth rate for each new game type played within a session. This cross-game participation may also include specific milestones, such as playing three different games in one session, to qualify for an enhanced jackpot.

### Example Walk-Through Scenario:

Player A starts their gaming session on an ETGT playing blackjack. After completing several rounds, they switch to baccarat and then proceed to play roulette. With each new game type, the Game Server tracks their participation and updates their cross-game eligibility. As Player A switches between games, their potential jackpot grows faster than it would if they had only played a single game.

Eventually, Player A triggers the jackpot while playing baccarat. Thanks to their cross-game participation, the jackpot pool is significantly larger than it would have been for a single-game session. The system rewards Player A with the enhanced jackpot, which is displayed on their ETGT, along with a breakdown showing how their cross-game participation contributed to the larger win.

### Player Interaction:

Players are encouraged to participate in multiple DETG games within a single session to increase their jackpot eligibility. This system introduces variety into gameplay, reducing fatigue from playing a single game and incentivizing players to explore different games. The dynamic tracking of cross-game participation enhances the overall experience, making each game type feel interconnected.

### Distinguishing Innovative Concepts:

The Cross-Game Jackpot Eligibility concept is distinct because it ties jackpot growth and player eligibility to cross-game participation rather than traditional factors such as wager size or game-specific outcomes. This approach promotes greater engagement across the DETG platform, as players are incentivized to switch between different games, thus increasing overall casino activity. This differs from prior art, which typically focuses on game-specific jackpots.

### Distinguishing Inventive Steps:

1. Cross-Game Participation Tracking: The system monitors and records a player's participation across multiple DETG games in real-time.
2. Jackpot Boost Calculation: The jackpot pool grows at an accelerated rate based on the number of different games the player participates in during a session.
3. Milestone-Based Eligibility: The system awards enhanced jackpots when players reach specific cross-game participation milestones, such as playing three or more game types in a session.

### 35 USC 101 Considerations:

The Cross-Game Jackpot Eligibility system provides a technical solution to the problem of player engagement in multi-game DETG environments by introducing a cross-game reward mechanism. This system integrates real-time tracking, dynamic jackpot adjustments, and milestone-based rewards to improve player interaction and retention. The technical improvements implemented by this system-such as cross-game data synchronization and dynamic jackpot pooling-offer a practical application of gaming technology, making it eligible for patentability under 35 USC 101.

### Data Input:

Data inputs include players' game participation, time spent in each game, and transitions between different DETG games. This information is used to track eligibility for the cross-game jackpot.

### Component Interactions and Procedural Steps:

1. ETGT: Players switch between different game types.
2. Game Server: Tracks player participation across multiple games and adjusts their eligibility for an enhanced jackpot.
3. Jackpot Pool System: Increases the jackpot pool based on the player's cross-game participation.
4. Player Tracking System: Logs each game the player participates in and communicates their eligibility to the Game Server.
5. Casino Network: Manages communication between ETGTs, the Game Server, and the Jackpot Pool System.

### Data Processing:

The system processes players' cross-game participation data and computes how their activity impacts the jackpot pool. The Game Server applies eligibility thresholds and milestone achievements to adjust the jackpot accordingly.

### Outputs and Responses:

When a player triggers the jackpot, the system calculates and displays the enhanced jackpot amount, showing how cross-game participation contributed to the final reward.

### Data Storage and Reporting:

The system logs cross-game participation data, jackpot contributions, and milestones achieved for each player. This information is stored for reporting and loyalty program integration.

### Error Handling and Security Measures:

The system includes error-checking to ensure that only valid cross-game participation is recorded and that players receive the appropriate jackpot rewards based on their activity.

### End of Interaction:

After the jackpot is awarded, the system resets the player's eligibility and prepares for the next session, ensuring that cross-game participation is accurately tracked from the start of each new session.

### Innovative Concept 11—Social Media Referral-Based Eligibility

### Identification of Concept:

The Social Media Referral-Based Eligibility concept enables players to qualify for special jackpot bonuses based on their social media engagement or referrals to new players. This innovative concept integrates social media interaction with DETG systems, providing players with additional ways to boost their jackpot eligibility by sharing their gameplay experiences or inviting friends to join the game.

### Sequence Diagram Components:

1. Electronic Table Game Terminal (ETGT): Players engage in DETG games and may receive special bonuses based on social media engagement.
2. Player A (Referrer): A player who refers others to join the game via social media.
3. Player B (Referral): A referred player who joins the game and contributes to Player A's jackpot eligibility.
4. Game Server: Tracks social media referrals and applies the associated bonuses to the player's jackpot eligibility.
5. Casino Network: Facilitates communication between the ETGTs, game server, and social media platforms.
6. Social Media Integration System: Connects the DETG system with social media platforms to verify referrals and engagement activities.

### Implementation Details:

To implement Social Media Referral-Based Eligibility, the DETG system integrates with popular social media platforms, allowing players to share their gaming experiences or invite friends to join. When a player refers a new user to the game, or when they engage in specific social media activities (such as sharing their jackpot wins), they receive a bonus that increases their eligibility for mystery jackpots.

The Social Media Integration System verifies these engagements and communicates with the Game Server to apply the appropriate bonuses. For example, if Player A refers Player B to join a DETG game, and Player B signs up and plays, Player A's jackpot eligibility is boosted by a predetermined percentage or multiplier.

### Example Walk-Through Scenario:

Player A is participating in a DETG session and uses a social media sharing feature embedded in their ETGT to invite their friend, Player B, to join the game. Player B signs up and begins playing, and the Social Media Integration System verifies the referral. As a result, Player A's jackpot eligibility is increased, and they now have a higher chance of winning a mystery jackpot. Additionally, if Player A wins the jackpot, they receive a bonus multiplier as a reward for their social media referral.

In a separate scenario, Player A shares their jackpot win on social media, and this activity also boosts their eligibility for future jackpots, providing further incentives to engage both socially and in-game.

### Player Interaction:

Players engage with social media directly from the ETGT, sharing their experiences or referring friends. Each social media activity contributes to the player's overall jackpot eligibility, creating a seamless integration of gameplay and social interaction. This feature encourages players to invite others to join the game, increasing overall casino activity and player engagement.

### Distinguishing Innovative Concepts:

This innovative concept distinguishes itself by integrating social media interaction directly into the DETG system. Unlike traditional jackpot systems that are limited to in-game participation, this concept extends player engagement beyond the game environment, linking social actions to tangible in-game benefits. This approach leverages the social nature of modern gaming to drive new player acquisition and increase engagement.

### Distinguishing Inventive Steps:

1. Referral-Based Jackpot Boosts: Players receive increased jackpot eligibility when they successfully refer new players via social media.
2. Social Media Sharing Bonus: Sharing jackpot wins or other gameplay achievements on social media boosts eligibility for future jackpots.
3. Social Media Verification: The system verifies social media engagements and applies the corresponding bonuses in real-time, ensuring players are rewarded for their activity.

### 35 USC 101 Considerations:

The Social Media Referral-Based Eligibility system integrates technical solutions to improve player engagement by combining social media interaction with DETG gameplay. By dynamically adjusting jackpot eligibility based on real-world actions such as referrals and social sharing, the system solves the problem of limited engagement and player retention. The technical implementation of real-time social media verification and jackpot adjustment provides a novel and practical application of gaming technology, making it eligible under 35 USC 101.

### Data Input:

Data inputs include player social media referrals, sharing activities, and engagement logs. These inputs are verified by the Social Media Integration System and transmitted to the Game Server for jackpot eligibility updates.

### Component Interactions and Procedural Steps:

1. ETGT: Players engage in gameplay and use social media sharing features.
2. Social Media Integration System: Verifies referrals and social sharing activities.
3. Game Server: Updates players' jackpot eligibility based on their social media activities.
4. Casino Network: Facilitates communication between the ETGTs, game server, and social media platforms.

### Data Processing:

The Social Media Integration System processes referral and engagement data from social media platforms. It then sends this information to the Game Server, which adjusts the player's jackpot eligibility based on the verified actions.

### Outputs and Responses:

When a player engages in social media activities, the system updates their jackpot eligibility and displays a notification on the ETGT showing the increased jackpot potential. If a jackpot is triggered, any social media-based bonuses are applied to the winnings.

### Data Storage and Reporting:

The system logs all social media engagement activities, referrals, and jackpot boosts for each player. This data is stored for reporting purposes and may be used for player loyalty programs or promotional campaigns.

### Error Handling and Security Measures:

The system includes safeguards to ensure that only verified social media engagements and referrals contribute to jackpot eligibility. Anti-fraud mechanisms are in place to prevent exploitation of the referral system.

### End of Interaction:

After the jackpot is awarded, the system resets the player's eligibility and prepares for the next session, ensuring social media engagement data is accurately tracked for future rewards.

### Innovative Concept 12—Third-Party Sponsored Jackpot Contributions

### Identification of Concept:

The Third-Party Sponsored Jackpot Contributions concept allows external sponsors (such as brands or corporations) to contribute to the jackpot pool in exchange for promotional rights during gameplay. This innovative concept introduces a new revenue stream for casinos by integrating advertising and sponsorships into the DETG experience, while also increasing the jackpot pool for players. Sponsors may contribute funds to the jackpot pool, and in return, their branding or promotional messages are displayed on ETGTs during the game.

### Sequence Diagram Components:

1. Electronic Table Game Terminal (ETGT): Displays sponsor branding and messages during gameplay.
2. Player A, Player B, etc.: Players who participate in DETG games with sponsored jackpots.
3. Game Server: Manages jackpot contributions, including those from third-party sponsors.
4. Jackpot Pool System: Aggregates contributions from both players and sponsors to grow the jackpot pool.
5. Casino Network: Facilitates communication between ETGTs, the Game Server, and sponsor systems.
6. Sponsor Contribution System: Handles third-party contributions and ensures promotional messages are displayed on ETGTs.

### Implementation Details:

The Third-Party Sponsored Jackpot Contributions concept may be implemented by integrating a sponsor contribution system into the existing DETG framework. Sponsors contribute funds directly to the jackpot pool, and in exchange, their branding or promotional messages are displayed on the ETGTs during gameplay. The Sponsor Contribution System tracks these contributions and ensures the corresponding promotions are shown to players.

The Game Server adjusts the jackpot pool based on both player wagers and sponsor contributions. For example, if a sponsor contributes a significant amount, the jackpot grows faster, increasing player excitement. The ETGT interface displays the sponsor's message during notable moments of gameplay, such as when the jackpot pool increases or when a player wins.

### Example Walk-Through Scenario:

A well-known beverage brand sponsors a DETG jackpot by contributing $10,000 to the pool. As Player A participates in a blackjack game, they see the brand's promotional message displayed on their ETGT screen each time the jackpot pool is updated. The Game Server adjusts the total jackpot to reflect the sponsor's contribution, increasing the potential winnings for all players.

During the game, Player A triggers the jackpot, which includes both player contributions and the sponsor's contribution. The promotional message from the sponsor is displayed prominently during the jackpot win, reinforcing the brand's visibility. Player A wins the enhanced jackpot, which includes the sponsor's contribution, and both the player and the sponsor receive exposure during the win event.

### Player Interaction:

Players engage with the DETG system as usual, with the added benefit of a larger jackpot pool thanks to third-party sponsorships. Players also see promotional messages from sponsors during gameplay, which enhances their awareness of the sponsor's products or services. The increased jackpot pool serves as a further incentive for players to participate in the game.

### Distinguishing Innovative Concepts:

The Third-Party Sponsored Jackpot Contributions concept introduces a novel integration of advertising and gaming by allowing external sponsors to fund jackpots in exchange for promotional exposure. This concept not only enhances the jackpot pool for players but also provides a new revenue stream for casinos. Traditional jackpot systems rely solely on player contributions, whereas this inventive system leverages external funding to create larger jackpots and increase player excitement.

### Distinguishing Inventive Steps:

1. Sponsor Contributions: Third-party sponsors contribute directly to the jackpot pool, increasing the total potential winnings.
2. In-Game Advertising: Sponsors receive promotional exposure during gameplay through dynamic ETGT displays.
3. Enhanced Jackpot Growth: The jackpot pool grows faster due to sponsor contributions, creating larger potential rewards for players.

### 35 USC 101 Considerations:

The Third-Party Sponsored Jackpot Contributions system improves the functionality of traditional DETG systems by integrating external contributions into the jackpot pool. This system solves the problem of limited jackpot growth by introducing a new revenue source from sponsors. The technical integration of sponsor contributions with dynamic in-game advertising and jackpot adjustments provides a practical solution to enhancing both player engagement and casino profitability, making it eligible for patentability under 35 USC 101.

### Data Input:

Data inputs include sponsor contributions, promotional message details, and player participation data. The Sponsor Contribution System manages the input and ensures the appropriate promotional messages are displayed on ETGTs.

### Component Interactions and Procedural Steps:

1. ETGT: Displays promotional messages and shows the updated jackpot pool, including sponsor contributions.
2. Sponsor Contribution System: Handles third-party contributions and ensures promotional messages are integrated into gameplay.
3. Game Server: Adjusts the jackpot pool based on both player wagers and sponsor contributions.
4. Jackpot Pool System: Aggregates contributions from players and sponsors to increase the jackpot pool.
5. Casino Network: Facilitates communication between the ETGTs, game server, and sponsor systems.

### Data Processing:

The system processes sponsor contributions and adjusts the jackpot pool accordingly. Promotional messages are dynamically displayed on the ETGTs based on real-time events, such as jackpot triggers or pool updates.

### Outputs and Responses:

When a player wins the jackpot, the system displays both the enhanced jackpot amount and the sponsor's promotional message on the ETGT screen, reinforcing brand visibility and rewarding the player with the larger jackpot.

### Data Storage and Reporting:

The system logs sponsor contributions, promotional message displays, and jackpot winnings for reporting and analysis. This data is used to measure the effectiveness of sponsorship campaigns and track player engagement.

### Error Handling and Security Measures:

The system includes checks to ensure that only verified sponsor contributions are added to the jackpot pool and that promotional messages are displayed correctly during gameplay.

### End of Interaction:

After the jackpot is awarded, the system resets the jackpot pool for the next game session and prepares to accept new sponsor contributions, ensuring continued integration of promotional content and enhanced jackpot growth.

### Innovative Concept 13: Dynamic Jackpot Reveal Animations

### Identification of Concept

This concept focuses on Dynamic Jackpot Reveal Animations where the animation adapts based on specific trigger conditions and the player's history in Dealer-controlled Electronic Table Games (DETGs). The animation reveals occur at notable moments such as triggering a jackpot or progressing towards it. This feature personalizes the jackpot reveal experience for each player by integrating visual effects tailored to their play style, bet history, or VIP status, creating a highly engaging, immersive experience. These animations are not just cosmetic; they may signal milestones in achieving jackpot eligibility, enhancing player excitement and casino engagement.

### Sequence Diagram Components

ETGTs (Electronic Table Game Terminals): Interfaces where players engage in DETGs and witness the reveal animations.
Player A, Player B, etc.: Players interacting with ETGTs during game sessions.
Casino Network Servers: Back-end systems responsible for tracking player actions, jackpot pools, and animation triggers.
Animation Control Software: Software component responsible for dynamically adjusting and displaying jackpot reveal animations based on input from the casino's network and player data.
Game Servers: Maintain game state and interface with the casino network to track conditions for triggering jackpot animations.
Player Tracking Servers: Store player-specific data such as bet history, win streaks, and engagement, which are used to customize animations.

### Implementation Details

In the DETG system, dynamic jackpot reveal animations may be implemented using a combination of animation rendering software and real-time player data. When a player makes significant progress toward a jackpot, the animation control system monitors their actions, including wagers, game outcomes, and specific triggers such as high-stake wins. The ETGTs communicate with a central server to determine if conditions for a jackpot animation have been met.

This animation may vary based on parameters such as:
Player VIP status: High-tier players may see more elaborate, personalized animations.
Recent gameplay history: Players with longer streaks of wins or high bet amounts may trigger grander reveals.
Specific game conditions: Each game type (e.g., baccarat or blackjack) may feature unique animations tailored to the game's mechanics. For instance, baccarat may have a dramatic card flip or suit-based animations, whereas blackjack may feature animations based on the number of cards drawn.

The DETG software will dynamically adjust the animations in real-time, allowing for high variability and personalization. This approach encourages sustained engagement by providing visual feedback that correlates with gameplay achievements, encouraging more frequent participation.

### Example Walk-Through Scenario

Player A sits down at an ETGT to play baccarat. As Player A places bets, the system tracks their progress and determines that they are nearing a potential jackpot trigger based on the player's betting patterns and game results. After a few rounds, Player A wins a significant amount.

Immediately, the dynamic reveal animation system kicks in, displaying a custom animation sequence across the ETGT screens, using elements specific to Player A's game history. The system pulls up Player A's VIP status, previous wins, and contribution to the jackpot pool, creating a unique visual experience that celebrates their achievement.

The ETGT terminal displays Player A's accumulated contributions to the jackpot pool while animating glowing cards and spinning chips that represent Player A's bets. This animation sequence culminates in a grand reveal showing that Player A has unlocked a part of the mystery jackpot pool, creating a sense of accomplishment and incentivizing continued play.

### Player Interaction

Players interact with the dynamic jackpot reveal system through their regular gameplay, with animations being triggered by their betting patterns, game outcomes, and jackpot progression. Player A may experience more elaborate animations after reaching a certain contribution level or triggering specific game events, such as hitting multiple consecutive wins.

These interactive animations not only entertain but also provide visual cues, signaling when players are closer to achieving jackpot eligibility. This enhances the gameplay experience by integrating visual storytelling, turning routine plays into a series of engaging, milestone-driven moments.

### Distinguishing Innovative Concepts

The dynamic jackpot reveal animation system introduces a novel way to enhance player engagement by visually signaling progression and rewards in DETGs. Unlike conventional slot machines or table games where jackpot winnings are simply displayed as text, this system integrates personalized, high-quality animations that evolve based on individual player data.

One significant novel detail is how the reveal animations adapt to different players. This is achieved by integrating real-time data from player tracking systems, which enables the DETG to tailor each reveal based on factors like play history and bet amount, offering a personalized experience. This system may also leverage augmented reality elements or interact with physical casino displays for even more immersive reveals.

### Distinguishing Inventive Steps

1. Dynamic animation personalization: Based on each player's history, wager amounts, and recent game outcomes, the system generates customized reveal sequences.
2. Triggering based on multiple gameplay factors: Instead of relying solely on jackpot wins, reveal animations may be triggered based on a combination of factors such as bet size, winning streaks, or even losses.
3. Seamless integration with player tracking systems: The system integrates with the player tracking server to ensure each animation is uniquely customized, offering a differentiated experience compared to conventional games.

### 35 USC 101 Considerations

This concept goes beyond abstract ideas by creating a specific improvement in the user experience of DETGs through customized jackpot reveal animations. The technical implementation solves the problem of player engagement by dynamically generating visual rewards based on real-time data inputs, which improves interaction with the game system. By leveraging advancements in real-time rendering and data tracking, this concept integrates visual storytelling into the gameplay in a manner that enhances the user interface and interaction with the underlying game technology. This inventive feature constitutes an improvement to existing gaming platforms by offering more than just static displays of information.

### Data Input

Players and the gaming system provide various inputs:
Player bets: Bet sizes and wager patterns are recorded to adjust the animations accordingly.
Game outcomes: Wins, losses, and bet sequences are monitored for jackpot trigger conditions.
Player engagement metrics: The system tracks metrics like session length and frequency of high-stake bets, which impact the animations' intensity and frequency.

### Component Interactions and Procedural Steps

1. ETGTs send player activity data, including bets and outcomes, to the central casino servers.
2. Casino network servers process this data to track the player's progress toward a jackpot.
3. The animation control system dynamically adjusts the reveal sequence based on real-time player inputs and sends the corresponding visual assets to the ETGT for display.
4. If certain criteria are met (e.g., a jackpot trigger), the animation system generates a fully dynamic reveal sequence based on the player's accumulated history and current game results.

### Data Processing

The system processes:
Real-time wager data to determine jackpot contribution and eligibility.
Player history to customize animations.
Game-specific logic for dynamically rendering the appropriate animation sequence based on DETG type (e.g., baccarat vs. blackjack).

### Outputs and Responses

Players receive dynamic animations on their ETGT screens, personalized based on their actions and overall gameplay. These animations signal progress toward potential jackpots or celebrate milestone achievements, enhancing the player's emotional investment.

### Data Storage and Reporting

The system stores detailed logs of player interactions, including animation triggers, wager amounts, and jackpot contributions. This data is stored both locally and on the casino network servers for reporting and auditing.

### Error Handling and Security Measures

The animation control system includes error detection algorithms that monitor network communication between the ETGT and the central servers. In case of network issues, the system reverts to pre-saved default animations, ensuring smooth gameplay without interruption.

### End of Interaction

At the end of the game session, the system transitions smoothly by logging out player data, resetting animation states, and preparing for the next player's interaction with a fresh set of conditions. This reset ensures that each player's experience remains unique.

### Innovative Concept 14: Dealer-Triggered Jackpot Events

### Identification of Concept

The Dealer-Triggered Jackpot Events concept introduces a mechanism where live dealers at DETG (Dealer-controlled Electronic Table Games) may manually trigger jackpot-related events during gameplay. These triggers may occur at specific moments determined by the dealer or casino, such as after a particular number of consecutive wins, or at designated time intervals to heighten player engagement. The concept enables dealers to play a more interactive role in controlling game flow and adding excitement by introducing jackpot opportunities at notable moments. This feature enhances player engagement by creating unpredictable yet dealer-controlled opportunities for significant winnings.

### Sequence Diagram Components

ETGTs (Electronic Table Game Terminals): Player interfaces where participants play live dealer games such as blackjack or baccarat.
Dealer Console: The system used by the live dealer to initiate gameplay, interact with game data, and manually trigger jackpot events.
Casino Network Servers: Track player interactions, wager data, and ensure proper logging of jackpot events.
Dealer: The live operator managing the DETG table, responsible for triggering jackpot events and ensuring fair play.
Animation/Display Systems: Responsible for visually signaling the jackpot event on the ETGT screens and optionally on larger casino displays.
Player A, Player B, etc.: Players interacting with the DETGs during the jackpot-triggered events.

### Implementation Details

To implement Dealer-Triggered Jackpot Events in DETG systems, each dealer console is equipped with a user interface that allows the dealer to initiate jackpot-related triggers during gameplay. These triggers may occur when the dealer identifies optimal points to heighten player excitement, such as:
Following a win streak by either the players or the dealer.
During slower periods of gameplay to re-engage players.
At regular or random intervals set by casino rules, allowing dealers some discretion in maintaining engagement.

The casino network servers continuously track game state, player actions, and wagers. When a dealer triggers a jackpot event, the system executes a sequence of commands that:
1. Alerts all connected ETGTs that a jackpot event has been initiated.
2. Displays dynamic animations and jackpot-related information on the ETGT screens.
3. Updates the central casino server to track the new jackpot event, including player participation and eligibility.

This system differentiates itself from typical automatic jackpot triggers by adding the element of human control. Dealers are trained to strategically initiate jackpots at moments that maximize player engagement. This approach leverages the dealer's unique role to provide a sense of immediacy and personal interaction not typically found in automated systems.

### Example Walk-Through Scenario

A live dealer begins a game of blackjack with several players seated at ETGTs. The dealer observes that Player A has hit a series of small wins over the last five rounds. To enhance excitement, the dealer initiates a jackpot event via their console. This event is broadcast to all players at the table, with animations showing that a special jackpot opportunity has been triggered.

Player A, along with the other participants, is informed via dynamic graphics on their ETGT that the next round will contribute directly to a special jackpot pool. Excitement builds as players increase their bets, hoping to capitalize on the jackpot opportunity.

After the round concludes, the system checks if any player hit the winning condition for the jackpot. Even if no one wins the jackpot, the system may display further messages encouraging continued play, while the dealer remains in control, ready to trigger the next event at a notable moment.

### Player Interaction

Players participate in Dealer-Triggered Jackpot Events through their normal gameplay on the ETGTs. When the dealer triggers a jackpot event, players are visually and audibly alerted via their terminals. During this event, players may be encouraged to increase their bets or participate in side bets that contribute to the jackpot pool.

What sets this concept apart is the human-driven timing of jackpot opportunities, where players react to the dealer's initiation of high-stakes moments, adding a layer of unpredictability and engagement not present in systems where jackpots are solely based on predefined outcomes.

### Distinguishing Innovative Concepts

This concept introduces dealer-controlled events in live DETG gameplay, which is distinct from prior art systems where jackpots are typically triggered based on fixed game conditions. By giving dealers the ability to trigger jackpot opportunities, the gameplay becomes more dynamic and responsive to the flow of the game and player behavior.

Novel details include:
Human-driven triggers: Dealers strategically initiate jackpot events based on game conditions, enhancing the timing and excitement of potential payouts.
Interaction between dealer and system: The integration of a dealer console interface that interacts directly with the casino's jackpot management system.
Dynamic event flow: The ability for dealers to adjust the game's pace by introducing jackpot events during notable moments, which increases player engagement and session duration.

### Distinguishing Inventive Steps

1. Dealer-initiated event triggering: Unlike conventional jackpots that are automated, the dealer directly controls when a jackpot event occurs.
2. Event broadcasting to ETGTs: Upon triggering, the dealer's command is communicated across the DETG system, ensuring synchronized gameplay across all terminals.
3. Dynamic game pace adjustment: The system allows the dealer to influence game rhythm, using jackpot events to sustain player interest during slower periods.

### 35 USC 101 Considerations

This concept is more than just a dealer's action; it constitutes a technical improvement in how jackpot events are triggered and managed in DETGs. The concept addresses player engagement problems by introducing real-time dealer control over jackpots, a specific technical solution integrated into the larger gaming network. The dynamic interaction between dealer consoles and ETGTs enhances the practical application of casino gaming systems, improving player interaction and adding layers of complexity to jackpot triggers.

### Data Input

The dealer console is the primary data input, with the dealer controlling the timing and frequency of jackpot events. The ETGTs provide player bet data, and casino servers track player eligibility and contribution to the jackpot pool. These inputs work together to dynamically adjust the game's pace.

### Component Interactions and Procedural Steps

1. Dealer console sends a signal to the casino server to initiate a jackpot event.
2. The casino network communicates with all connected ETGTs to notify players of the event.
3. Player interactions with the game continue as normal, with the added excitement of the jackpot trigger.
4. After the event, servers update the jackpot pool and determine if any players are eligible for payouts.

### Data Processing

The system processes real-time game state data from both the dealer and players. When the dealer triggers a jackpot event, the system calculates each player's contributions, checks conditions for winning, and updates the jackpot pool in real-time.

### Outputs and Responses

ETGTs display dynamic animations and updates regarding the jackpot pool. Players receive immediate feedback on their contribution and progress, while the dealer may also be prompted for follow-up actions based on game outcomes.

### Data Storage and Reporting

The system logs each jackpot event, including the dealer's actions, player interactions, and final outcomes. These logs are stored for auditing purposes and future event optimization.

### Error Handling and Security Measures

The system incorporates error-checking protocols to ensure jackpot events are properly logged, and that any discrepancies between dealer actions and system responses are flagged for review. Security measures ensure that only authorized dealers may trigger jackpot events.

### End of Interaction

At the conclusion of the jackpot event, the system resets the dealer's console for the next event and updates all ETGTs to return to the regular game state. Player contributions are cleared, and the game continues as normal, ready for future jackpot triggers.

### Innovative Concept 15: Time-Based Jackpot Contribution Limits

### Identification of Concept

The Time-Based Jackpot Contribution Limits concept introduces time windows during which players may contribute to the mystery jackpot pool. This encourages players to place higher wagers or more frequent bets during specific time periods, creating a sense of urgency and increased participation. Once the window closes, no further contributions may be made to that specific jackpot pool until the next window opens. This concept adds a temporal dynamic to DETGs, driving engagement during designated periods and providing casinos with a way to manage jackpot pools more effectively by controlling contribution periods.

### Sequence Diagram Components

ETGTs (Electronic Table Game Terminals): Player interfaces used to place bets and monitor contribution windows.
Casino Network Servers: Track active jackpot pools, player contributions, and manage opening and closing times for contribution windows.
Timer System: Synchronizes the start and end of each contribution window, ensuring uniformity across all ETGTs.
Player A, Player B, etc.: Players participating in the DETG and contributing to the jackpot during open windows.

### Implementation Details

In DETG systems, Time-Based Jackpot Contribution Limits may be implemented by defining specific contribution periods controlled by the casino's back-end servers. These periods may vary in length and frequency, depending on casino preferences. For example:
A jackpot pool may open for contributions during the first 10 minutes of every hour.
Alternatively, contribution windows may be randomized to occur unpredictably, adding excitement.

The system is equipped with a timer module connected to the casino network. As each contribution window opens, all ETGTs display messages prompting players to place side bets that contribute to the jackpot. The casino network servers track player contributions and update the jackpot pool in real-time.

When the window closes, the system prevents further contributions, and the ETGTs display notifications signaling the close of the jackpot contribution period. Players continue playing, knowing that they have contributed to the current jackpot and must wait for the next window to reopen.

### Example Walk-Through Scenario

Player B sits down at a DETG (Dealer-controlled Electronic Table Game) terminal to play a round of baccarat. Upon starting the session, a notification appears on the ETGT screen indicating that the jackpot contribution window is currently open for the next 10 minutes. Player B places a series of bets, including side bets, to contribute to the growing mystery jackpot pool. The system tracks Player B's contributions and shows real-time updates on how much of the pool has been accumulated across all players participating in the time window.

As the time limit nears its end, the ETGT displays a countdown, creating a sense of urgency and encouraging additional contributions from Player B and others. At the end of the 10-minute period, the system closes the contribution window, and the ETGTs notify players that no further contributions will be accepted until the next window opens. Player B continues gameplay, knowing that they have contributed to the jackpot and will be eligible to win when it is triggered, but must wait for the next opportunity to contribute further.

### Player Interaction

Players interact with the Time-Based Jackpot Contribution Limit feature through their standard gameplay on ETGTs, where they receive notifications about the opening and closing of contribution windows. During these windows, players are encouraged to place bets that contribute to the jackpot pool, with visual indicators such as countdown timers and growing jackpot displays enhancing the excitement and urgency.

The timed nature of the contribution windows adds an extra layer of strategy to the game, as players must decide when and how much to contribute within the allotted time. The dynamic aspect of time limits creates a sense of anticipation, motivating players to engage more actively during open windows, and offering a clear distinction from standard gameplay where contributions are continuously accepted.

### Distinguishing Innovative Concepts

This innovative concept introduces timed limitations on jackpot contributions, distinguishing it from traditional progressive jackpots where contributions are typically made continuously throughout gameplay. By setting specific time periods for contributions, the concept creates targeted moments of heightened engagement and excitement, which may be strategically aligned with the casino's operational goals, such as increasing player activity during off-peak hours or promoting specific games.

Novel details include:
1. Timed contribution windows: Contribution to the jackpot pool is limited to specific time frames, which may be fixed, randomized, or tied to certain in-game events.
2. Real-time updates and notifications: Players receive live feedback on the status of the jackpot pool and how much time remains to contribute, increasing their engagement during these windows.
3. Casino-controlled timing: The casino may adjust the frequency and length of contribution windows, allowing for dynamic gameplay customization based on player activity patterns.

### Distinguishing Inventive Steps

1. Opening and closing of contribution windows: The system dynamically controls when contributions are allowed, providing distinct periods where players may add to the jackpot pool.
2. Real-time countdown and feedback: ETGTs display countdowns and updates to notify players of the time remaining for contributions, fostering a sense of urgency.
3. Post-window lockout: Once the contribution window closes, no further bets are accepted into that specific jackpot pool, differentiating it from conventional systems where contributions are continuously made.

### 35 USC 101 Considerations

This innovative concept involves a specific technical improvement in how jackpot contributions are managed within DETGs. The Time-Based Jackpot Contribution Limit system introduces a time-sensitive mechanic that directly improves player engagement by controlling when contributions are allowed. This is a novel improvement over the existing systems by introducing a dynamic and controlled contribution mechanism, enhancing both casino operations and player excitement. The implementation integrates timers, contribution tracking, and ETGT interfaces to form a specific and non-abstract solution to a real-world problem in casino gaming systems.

### Data Input

Player bets: Wager amounts and side bets placed during the open window are tracked by the casino servers.
System timing data: Timers control the opening and closing of contribution windows, providing synchronized data to ETGTs for countdown displays.
Player participation data: The system records how much each player has contributed to the jackpot pool during the open window.

### Component Interactions and Procedural Steps

1. The casino network server activates a contribution window, notifying all connected ETGTs.
2. Players are alerted to the open window via on-screen notifications and countdown timers.
3. ETGTs track all side bets made during the window and send this data to the casino server, which updates the jackpot pool in real-time.
4. When the window closes, further contributions are blocked, and players are notified that no more bets may be added to the pool until the next window opens.

### Data Processing

The system processes:
Real-time bet data: It calculates player contributions to the jackpot during the open window and updates the pool accordingly.
Timing logic: It synchronizes timers across ETGTs to ensure all players have equal opportunity to contribute within the same time frame.

### Outputs and Responses

Players receive visual and auditory notifications when the contribution window opens, along with real-time updates on the jackpot pool size. After the window closes, players are alerted that the contribution period has ended, but gameplay continues as normal.

### Data Storage and Reporting

The system stores all player contributions during each jackpot window and logs the total amounts contributed by each player for auditing and payout purposes. This data is stored in the casino's jackpot management system.

### Error Handling and Security Measures

The system includes built-in safeguards to ensure that all contributions are properly tracked within the set time windows. If a window fails to close due to network issues, an automatic timeout triggers, ensuring no additional contributions are accepted beyond the designated time period.

### End of Interaction

At the end of the contribution window, the system resets and prepares for the next window to open. Player contributions are logged, and the jackpot pool continues to accumulate until the next window or the jackpot is triggered.

### Innovative Concept 16: Threshold-Based Jackpot Activation

### Identification of Concept

The Threshold-Based Jackpot Activation concept triggers a jackpot only after a specific cumulative bet threshold is reached. This system allows casinos to set a predefined total bet amount (e.g., $100,000) that may be wagered by players across all ETGTs before the jackpot becomes active. This mechanism encourages players to contribute more towards the jackpot by providing a clear target that may be achieved collectively before the jackpot may be won. The threshold may be displayed to all players, creating a communal sense of progress as they work together to unlock the jackpot.

### Sequence Diagram Components

ETGTs (Electronic Table Game Terminals): Interfaces through which players place bets and monitor the cumulative threshold.
Casino Network Servers: Track the total wagered amount across all participating terminals and determine when the jackpot threshold has been reached.
Threshold Display: Displays the current progress towards the threshold, visible on ETGTs or on central casino displays.
Player A, Player B, etc.: Players contributing to the cumulative bet total through gameplay.

### Implementation Details

In the DETG system, Threshold-Based Jackpot Activation is implemented by setting a target wager amount across all active ETGTs in a game. The casino network server monitors all bets placed by players and calculates the total amount wagered. Once this cumulative total reaches the pre-set threshold, the jackpot becomes active, meaning that any eligible player may win the jackpot in subsequent game rounds.

The system continuously updates the cumulative total and displays this information on ETGT screens or central casino displays. This creates a shared goal among all players, encouraging more frequent and higher bets to reach the jackpot activation threshold.

### Example Walk-Through Scenario

At a DETG baccarat table, players are informed that the jackpot will only activate once $50,000 in total bets have been placed across all terminals. As Player A and other participants place their bets, the threshold display on their ETGTs shows the cumulative progress toward this goal. Every bet placed adds to the total, and as the threshold gets closer, players are motivated to place larger bets or participate more frequently to unlock the jackpot. Once the $50,000 threshold is reached, the ETGTs display a message announcing that the jackpot is now active, and any subsequent wins may trigger the payout. Players are further encouraged to continue playing, knowing that they have helped unlock the jackpot and are now eligible for a potentially large payout.

### Player Interaction

Players interact with this concept by contributing to the cumulative bet pool through their regular gameplay. The threshold display provides real-time feedback on how close the table is to reaching the jackpot activation point, fostering a sense of community as players collectively work toward unlocking the jackpot. This dynamic encourages more active participation and higher bets, as players are incentivized to help reach the threshold faster.

### Distinguishing Innovative Concepts

The notable distinguishing feature of this concept is the cumulative bet threshold required to activate the jackpot. Unlike traditional progressive jackpots, where players continuously contribute to a growing pool, this system may require a collective effort to reach a specific target before the jackpot becomes available. The real-time display of progress towards this threshold adds a novel communal element to gameplay, motivating players to work together toward unlocking the jackpot.

Novel details include:
1. Cumulative bet tracking: The system monitors all player wagers and updates the cumulative total in real-time.
2. Threshold-based activation: The jackpot does not become available until a specific total bet amount is reached, adding a strategic layer to gameplay.
3. Shared player goal: The system encourages communal participation, as all players contribute to unlocking the jackpot together.

### Distinguishing Inventive Steps

1. Cumulative tracking of player wagers: The system continuously aggregates all bets placed across multiple ETGTs and updates the total contribution towards the jackpot threshold in real-time. This ensures that every player's bet, no matter how small, contributes to the overall target.
2. Threshold-based jackpot trigger: The system only activates the jackpot once the collective wager threshold is reached. Until this point, players contribute to the pool without the chance to win the jackpot, which creates a clear goal for players to work towards collectively.
3. Visual and auditory feedback: Once the threshold is met, the system provides immediate feedback to all players, signaling that the jackpot is now active. This feedback may include on-screen animations, sound effects, and updated displays on all ETGTs, ensuring that every player is aware that the jackpot has become available.

### 35 USC 101 Considerations

The Threshold-Based Jackpot Activation concept represents a specific improvement to existing DETG systems by introducing a goal-oriented trigger for jackpot activation, which adds an element of player cooperation and strategic betting. This is more than a simple abstract idea because it involves a technical solution to enhance player engagement through dynamic threshold tracking and communal participation. The concept integrates real-time data processing and feedback mechanisms into the existing DETG framework, thereby improving the functionality of the system and solving a specific problem related to sustained player interest in jackpot-based games. This creates a practical application where the cumulative nature of the threshold may require coordinated player participation, offering a discernible advancement in gaming technology.

### Data Input

Player wager data: Every bet placed by players is recorded and contributes to the overall cumulative pool. Each wager is processed and tracked in real-time by the casino server.
Threshold data: The pre-determined target amount is stored in the system and serves as the activation point for the jackpot. This threshold may be adjusted by the casino to suit different games or promotional events.
Game state data: The system constantly monitors game progress to determine when the threshold is met and when to trigger the jackpot activation.

### Component Interactions and Procedural Steps

1. ETGTs send player bet data to the casino network server.
2. The casino network server aggregates these bets and updates the cumulative wager total.
3. The threshold display on each ETGT updates in real-time, showing players how much more needs to be wagered to reach the jackpot activation point.
4. Once the cumulative total reaches the pre-set threshold, the server triggers the jackpot activation, which is communicated back to the ETGTs.
5. The ETGTs provide feedback to the players, alerting them that the jackpot is now active and may be won during subsequent game rounds.

### Data Processing

The system processes real-time wager data from all active players, updating the cumulative total every time a bet is placed. The system also tracks game outcomes to determine if the jackpot conditions are met after the threshold is reached. Once the jackpot is triggered, the system processes additional data to calculate potential payouts and allocate winnings according to the predefined rules.

### Outputs and Responses

Real-time updates on the cumulative threshold: Players receive continuous visual feedback on their ETGTs, showing how much has been contributed towards the jackpot.
Jackpot activation notification: Once the threshold is met, the system triggers visual and auditory alerts, notifying players that the jackpot is now available.
Game continuation: Even after the jackpot is activated, gameplay continues as normal, with the added excitement of an available jackpot payout.

### Data Storage and Reporting

The system stores all data related to player wagers, cumulative totals, and jackpot activations. This information is logged and may be accessed for auditing purposes or to generate reports on player engagement and jackpot distribution.

### Error Handling and Security Measures

The system includes checks to ensure that the cumulative total is correctly tracked and updated. If there is a discrepancy or network failure, the system reverts to the last known valid total, ensuring that no incorrect contributions are recorded. Security measures prevent tampering with the jackpot threshold or player contributions, and only authorized casino personnel may modify threshold settings.

### End of Interaction

Once the jackpot is activated, the system resets for the next threshold cycle. The cumulative total is reset, and players continue to place wagers toward the next activation point. This ensures that the system operates in a loop, maintaining player engagement and offering multiple opportunities for jackpot payouts across different sessions.

### Innovative Concept 17: Double Jackpot Multiplier

### Identification of Concept

The Double Jackpot Multiplier concept introduces promotional periods during which jackpots are doubled for players who meet specific criteria, such as playing during off-peak hours or achieving certain in-game accomplishments. This multiplier is applied to the existing jackpot pool, effectively doubling the payout for players who win the jackpot during the promotional window. This feature incentivizes players to participate during designated times or to engage in certain game activities to qualify for the enhanced jackpot, creating both time-based and achievement-based incentives for increased play.

### Sequence Diagram Components

ETGTs (Electronic Table Game Terminals): Player interfaces where players place bets and track their eligibility for the jackpot multiplier.
Casino Network Servers: Manage the promotional period, track player eligibility, and calculate the doubled jackpot payouts.
Multiplier Eligibility Logic: Determines which players qualify for the double jackpot multiplier based on criteria such as time of play, wager amounts, or specific in-game achievements.
Player A, Player B, etc.: Players interacting with the DETGs, who may or may not qualify for the double jackpot multiplier based on their actions.
Promotional Display: Communicates the double jackpot event to players, showing them when the multiplier is active and what criteria may be met to qualify.

### Implementation Details

The Double Jackpot Multiplier may be implemented by defining promotional windows during which the multiplier is active. These windows may be based on specific time periods (e.g., off-peak hours), certain game events, or the achievement of milestones such as consecutive wins. The system tracks player eligibility by monitoring their actions in real-time and applying the multiplier only to those who meet the defined criteria.

The casino network servers manage the jackpot pool and calculate the adjusted payouts for players who qualify for the multiplier. The system dynamically updates the ETGTs with promotional information, ensuring that players are aware of when the multiplier is active and what they need to do to qualify. This adds an extra layer of excitement to regular jackpot gameplay, encouraging players to participate more during promotional periods.

### Example Walk-Through Scenario

Player A begins playing blackjack on a DETG during a designated promotional period where the double jackpot multiplier is active. The ETGT displays a notification indicating that any jackpot won during this time will be doubled. Player A places a series of bets and wins the regular jackpot. Because the multiplier is in effect, the system automatically applies the 2× multiplier to the jackpot payout, doubling Player A's winnings.

Throughout the promotional period, other players, such as Player B, also place bets, knowing that the potential jackpot payout is significantly larger than usual. As the promotional window draws to a close, the ETGT displays a countdown, encouraging players to place their final bets before the multiplier period ends.

### Player Interaction

Players interact with the Double Jackpot Multiplier feature by participating in regular gameplay during promotional periods. The ETGTs notify players when the multiplier is active and provide real-time updates on their eligibility. Players may also receive prompts or rewards for reaching specific milestones that qualify them for the multiplier, such as hitting a streak of wins or betting above a certain threshold.

The multiplier provides an additional layer of excitement to gameplay, as players are aware that their potential winnings are significantly higher than usual. This encourages more frequent and higher bets during the promotional period, as players aim to take advantage of the enhanced jackpot.

### Distinguishing Innovative Concepts

The Double Jackpot Multiplier introduces a time-limited promotional mechanism that incentivizes player participation through enhanced payouts. Unlike standard jackpots, where the payout remains fixed, this concept allows for a temporary increase in the potential winnings based on specific criteria.

Novel details include:
1. Promotional multiplier periods: Jackpots are doubled for players who meet the criteria during designated promotional windows.
2. Eligibility-based rewards: Players must meet certain criteria, such as playing during specific times or achieving in-game milestones, to qualify for the doubled jackpot.
3. Dynamic updates on ETGTs: Players are continuously informed of their eligibility and the remaining time for the multiplier period, creating a sense of urgency and engagement.

### Distinguishing Inventive Steps

1. Promotional window management: The system controls when the multiplier is active and ensures that only players participating during these times are eligible for the enhanced payout.
2. Eligibility tracking: The system monitors player actions and applies the multiplier only to those who meet the predefined criteria.
3. Dynamic jackpot adjustment: Once a player qualifies and wins the jackpot, the system applies the multiplier and calculates the doubled payout in real-time.

### 35 USC 101 Considerations

The Double Jackpot Multiplier feature enhances the functionality of the DETG system by introducing promotional mechanics that temporarily alter jackpot payouts. This is a specific technical solution to the problem of maintaining player engagement during off-peak periods or encouraging sustained gameplay. The system integrates real-time data tracking, eligibility logic, and dynamic jackpot calculations to create a practical application of gaming incentives, going beyond an abstract idea by solving a real-world problem in casino operations.

### Data Input

Player bet data: The system tracks each player's bets to determine their contribution to the jackpot pool and their eligibility for the multiplier.
Eligibility criteria: Data related to the promotional period, including the time of play, wager amounts, and specific player achievements, is collected and used to determine which players qualify for the Double Jackpot Multiplier.
Game results: The system processes each player's game outcomes to determine if a jackpot has been won and if the multiplier should be applied.

### Component Interactions and Procedural Steps

1. ETGTs notify players when the promotional window opens and track their gameplay, including bet amounts and game outcomes.
2. The casino network server monitors real-time data from all participating ETGTs to determine which players are eligible for the double jackpot based on the promotion's criteria.
3. As players place bets and play through the games, their wager data is sent to the multiplier eligibility logic, which checks for qualifications such as playing during the promotional period or achieving certain milestones.
4. If a jackpot is won during the promotional window, the system automatically applies the multiplier and adjusts the payout accordingly.
5. The ETGTs display the updated jackpot amount and notify the player of the doubled winnings.

### Data Processing

The system processes:
Real-time wager data: This data is continuously tracked to determine player contributions to the jackpot pool and their eligibility for the multiplier.
Promotional criteria: The system compares each player's actions (e.g., time of play, bet amounts) against the predefined criteria for the promotional period to determine whether the double jackpot multiplier should be applied.
Jackpot payout calculations: Once a player wins the jackpot, the system applies the multiplier and calculates the enhanced payout in real time.

### Outputs and Responses

Promotional notifications: The ETGTs display messages notifying players of the active Double Jackpot Multiplier period and their eligibility for the enhanced payout.
Jackpot activation: When a player wins the jackpot during the promotional period, the system immediately applies the multiplier and informs the player of their doubled winnings.
Countdown timers: As the promotional period nears its end, the system displays countdown timers on the ETGTs, encouraging players to place final bets before the multiplier period expires.

### Data Storage and Reporting

The system logs all player activity during the promotional period, including the total number of bets placed, the number of players who qualified for the multiplier, and the jackpots won. This data is stored for auditing, reporting, and analysis purposes, helping casinos evaluate the effectiveness of the promotion.

### Error Handling and Security Measures

The system includes safeguards to ensure that the jackpot multiplier is only applied to eligible players during the promotional window. If a player mistakenly receives the multiplier outside of the designated period, the system may reverse the payout. Additionally, all eligibility criteria are securely managed to prevent tampering or misuse of the promotion.

### End of Interaction

At the end of the promotional window, the system automatically deactivates the Double Jackpot Multiplier and resets the jackpot pool to its normal state. Players are notified that the promotion has ended, and regular gameplay resumes without the enhanced payout potential. The system prepares for future promotional windows by resetting the eligibility criteria and player tracking mechanisms.

### Innovative Concept 18: Mystery Jackpot Based on Wager Sequence

### Identification of Concept

The Mystery Jackpot Based on Wager Sequence involves triggering a mystery jackpot by requiring players to place a specific sequence of wager amounts over multiple rounds in a DETG (Dealer-controlled Electronic Table Game). This concept adds a strategic layer to gameplay, as players may be mindful of not just their current bet but the sequence of previous wagers to become eligible for a jackpot. The sequence may be a progression of increasing bets, alternating bet sizes, or a series of matching wagers. This structure encourages consistent betting patterns and incentivizes players to stay engaged for longer periods, as deviating from the sequence may disqualify them from the jackpot.

### Sequence Diagram Components

ETGTs (Electronic Table Game Terminals): Player terminals where wagers are placed and sequences are tracked.
Casino Network Servers: Track wager data across multiple rounds and compare against pre-set jackpot-triggering sequences.
Player A, Player B, etc.: Players participating in the game by placing wagers over multiple rounds.
Jackpot Sequence Logic: Software logic that determines whether a player's betting sequence qualifies for a jackpot trigger.
Game Servers: Ensure game state synchronization, process wagers, and communicate with the casino network to track eligibility.

### Implementation Details

In this system, the Casino Network Server tracks each player's bets round-by-round, checking whether the player follows the required sequence of wager amounts to trigger the mystery jackpot. For example, a jackpot may only be triggered if a player places bets in increasing amounts over five rounds, or alternates between high and low wagers. The Jackpot Sequence Logic monitors these wagers in real-time and communicates with the Game Server to determine if the sequence has been completed.

Each ETGT displays the player's current sequence progress, alerting them if they are on track to trigger the jackpot or if they have broken the required sequence. This notification system keeps players engaged, encouraging them to maintain strategic betting patterns.

Once a player completes the required sequence, the system triggers the jackpot and updates all terminals, ensuring transparency and excitement for other players. The payout is then processed, and the sequence tracker is reset for the next jackpot cycle.

### Example Walk-Through Scenario

Player A sits down at a DETG terminal to play blackjack. A message on the screen informs Player A that a mystery jackpot is available, which may only be triggered by placing five consecutive bets that increase by at least $5 each round.

In the first round, Player A places a $10 bet, followed by a $15 bet in the second round, and continues to increase their bet by $5 each round. The ETGT tracks Player A's progress, displaying a visual indicator of how close they are to completing the sequence. By the fifth round, Player A places a $30 bet, completing the sequence.

The system checks Player A's bet history, confirms that the sequence has been followed, and triggers the mystery jackpot. The screen lights up, animations play, and Player A is awarded the mystery jackpot, which is added to their balance. The system then resets the sequence tracker, allowing other players to attempt the same sequence.

### Player Interaction

Players engage with this system by placing bets that follow specific sequences defined by the Jackpot Sequence Logic. The sequence is clearly displayed on the ETGT, showing players what bet they need to place next in order to qualify for the jackpot. If a player deviates from the required sequence, the system notifies them, giving them a chance to start the sequence over in subsequent rounds.

This interaction encourages strategic betting and longer play sessions, as players are motivated to stay in the game to complete the sequence and trigger the jackpot. One aspect of novelty of this system lies in the added layer of strategy and suspense, as players must pay attention to both the current game and their overall betting pattern.

### Distinguishing Innovative Concepts

The Mystery Jackpot Based on Wager Sequence is novel in that it links the trigger for a jackpot to a series of wager amounts, rather than game outcomes or random chance. This adds a strategic component to the jackpot, requiring players to plan their bets in advance.

Notable distinguishing features include:
1. Sequence-based eligibility: Unlike conventional jackpot systems that are either random or based on game outcomes, this system may require players to place specific wagers in a defined sequence.
2. Real-time feedback: Players receive immediate updates on their progress toward the jackpot, allowing them to adjust their strategy as needed.
3. Strategic betting: The system encourages longer play sessions and consistent betting patterns, increasing engagement and revenue for the casino.

### Distinguishing Inventive Steps

1. Tracking wager sequences: The system continuously monitors each player's bets across multiple rounds, checking for compliance with the jackpot-triggering sequence.
2. Real-time sequence validation: The system validates each wager as it is placed, ensuring that the player is on track to complete the sequence.
3. Dynamic jackpot triggering: Once the required sequence is completed, the system automatically triggers the jackpot and rewards the player, resetting the sequence tracker for the next round.

### 35 USC 101 Considerations

This innovative concept is more than a mere abstract idea, it presents a specific improvement to how mystery jackpots are triggered in DETGs by introducing a sequence-based mechanic. The system integrates real-time bet tracking, player feedback, and dynamic jackpot calculations, solving a technical problem in existing gaming systems by providing a new way to trigger jackpots that encourages strategic play. This improvement integrates into a practical application, enhancing the overall functionality of DETGs and offering a unique player experience.

### Data Input

Wager data: The system tracks each bet placed by players, monitoring for adherence to the pre-set sequence.
Sequence criteria: The specific betting pattern required to trigger the jackpot is stored and compared against player actions.
Game state data: The system monitors each round of the game to ensure proper bet tracking and jackpot conditions.

### Component Interactions and Procedural Steps

1. ETGTs send wager data to the Casino Network Server, where the bets are logged and compared to the required sequence.
2. Jackpot Sequence Logic checks each wager in real time to determine if it matches the sequence.
3. If the sequence is completed, the Game Server triggers the jackpot, sending notifications to the ETGTs and updating the jackpot pool.

### Data Processing

The system processes wager data from multiple players, tracking each bet against the required sequence. The Jackpot Sequence Logic compares each bet in real time, ensuring that the player follows the required sequence to trigger the jackpot.

### Outputs and Responses

Players receive real-time feedback on their progress towards completing the sequence via visual indicators on their ETGTs. When the sequence is completed, the system triggers the jackpot, displaying animations and updating the player's balance with their winnings.

### Data Storage and Reporting

The system logs all wager sequences and jackpot triggers for auditing and reporting purposes. This data is stored on the Casino Network Server and may be used to analyze player behavior and optimize the system for future sessions.

### Error Handling and Security Measures

The system includes safeguards to ensure that the correct sequence is tracked and that jackpots are only triggered when the sequence is completed. If a discrepancy occurs, the system flags the error for review and prevents jackpot payouts until the issue is resolved.

### End of Interaction

Once a jackpot is triggered, the system resets the sequence tracker and notifies all players that the jackpot has been won. The next sequence begins immediately, allowing players to start working toward the next jackpot trigger.

### Innovative Concept 19: Multiple Player Contribution Pools

### Identification of Concept

The Multiple Player Contribution Pools concept introduces a jackpot system where players contribute to different jackpot pools based on their wager amounts. Each player's contribution to the jackpot pool is proportional to their bet size, meaning that higher-stake players contribute more and, correspondingly, have a larger share of the jackpot if it is won. This concept allows for differentiated jackpot tiers, where players may compete for multiple jackpots simultaneously based on their individual contribution levels.

### Sequence Diagram Components

ETGTs: The terminals where players place wagers and are allocated into different contribution pools based on their bet amounts.
Casino Network Servers: Track player contributions and manage the distribution of the jackpot across multiple pools.
Player A, Player B, etc.: Players placing bets of varying amounts, contributing proportionally to different jackpot pools.
Contribution Pool Logic: Software that calculates how much each player contributes to the different jackpot tiers based on their wager.

### Implementation Details

In this system, players at the ETGTs place their bets as normal. The Contribution Pool Logic calculates the proportional contribution of each bet to the various jackpot pools. For example, smaller bets may contribute to a lower-tier jackpot, while higher bets contribute to both lower and higher-tier jackpots.

When a jackpot is triggered, the system calculates the payout based on the player's contribution to the pool. If a player has been contributing to multiple jackpot pools, they may be eligible for winnings from more than one pool, depending on the outcome of the game and their wager amounts.

### Example Walk-Through Scenario

Player A places a series of bets on a DETG, contributing a percentage of their wager to three different jackpot pools. Player B, who is placing smaller bets, only contributes to the lowest-tier jackpot pool. As the game progresses, the system tracks each player's contributions to the respective pools. When the jackpot is triggered, Player A wins a share of all three pools, while Player B only wins from the lowest-tier pool.

### Player Interaction

Players interact with the Multiple Player Contribution Pools by placing wagers that automatically allocate their contributions to the different jackpot pools based on the size of their bets. The ETGTs display real-time information showing which pools a player is contributing to and how their contributions stack up against those of other players.

For example, Player A, placing larger bets, contributes proportionally to all three jackpot pools (low-tier, mid-tier, and high-tier), while Player B, making smaller bets, only contributes to the low-tier jackpot. Players may adjust their bet amounts to participate in different pools, adding a strategic element to their gameplay. This interaction encourages players to vary their bets, aiming to contribute more to higher-tier jackpots for larger potential payouts.

### Distinguishing Innovative Concepts

This concept is distinguished by its tiered contribution system, where players' contributions are proportional to their wagers, allowing them to participate in multiple jackpot pools simultaneously. Unlike traditional jackpots where all players contribute to a single pool regardless of bet size, this system rewards players based on the size of their contributions, creating a more personalized and equitable distribution of potential winnings.

Notable novel features include:
1. Multiple-tiered jackpot pools: Players may contribute to different pools, depending on their bet amounts, creating a layered system of potential payouts.
2. Proportional contribution system: Players' jackpot contributions are directly tied to the size of their wagers, meaning higher-stake players have greater potential winnings.
3. Dynamic pool allocation: The system automatically adjusts player contributions to the appropriate pools in real time, ensuring that each bet is proportionally represented in the jackpot structure.

### Distinguishing Inventive Steps

1. Tiered jackpot pool management: The system manages multiple jackpot pools simultaneously, allocating player contributions based on their bet sizes.
2. Proportional player contributions: The system dynamically calculates and allocates each player's contribution to the different jackpot pools based on the amount they wager in each game.
3. Real-time updates and feedback: The ETGTs provide continuous feedback to players on which pools they are contributing to, as well as updates on the current jackpot totals for each tier.

### 35 USC 101 Considerations

The Multiple Player Contribution Pools concept provides a specific, practical solution to the problem of jackpot fairness in multiplayer DETG environments by introducing a tiered jackpot system that allocates contributions based on wager size. This is more than an abstract idea because it involves the application of technology to solve a concrete problem in gaming systems, improving the player experience and offering a more personalized and equitable way to distribute jackpots. The technical implementation-using real-time wager tracking and dynamic contribution allocation-integrates into a practical application that enhances both casino operations and player engagement.

### Data Input

Wager data: The system tracks the amount each player bets in real time and calculates their contribution to each jackpot pool.
Jackpot pool thresholds: Each jackpot pool has predefined thresholds that determine which wagers contribute to which pool, ensuring that larger bets are allocated to higher-tier pools.
Player contribution data: The system continuously updates each player's contribution to the jackpot pools based on their bet history.

### Component Interactions and Procedural Steps

1. Players place wagers via the ETGTs, which transmit bet amounts to the Casino Network Server.
2. The Contribution Pool Logic calculates how much of each bet contributes to the various jackpot pools, dividing the player's contribution proportionally across the low, mid, and high-tier pools.
3. The system tracks cumulative contributions to each pool in real time, displaying current jackpot totals on the ETGTs.
4. When a jackpot is triggered, the system calculates each player's share based on their contributions to the respective pools, distributing payouts accordingly.

### Data Processing

The system processes wager data to calculate each player's contribution to the multiple jackpot pools. This involves determining which pool(s) each wager qualifies for and updating the cumulative jackpot totals for each pool. When a jackpot is triggered, the system processes player contributions and calculates payouts based on the respective pool's size and the player's proportional contribution.

### Outputs and Responses

Players receive continuous updates on their contributions to the jackpot pools and the current size of each pool. When a jackpot is triggered, the system notifies all players of the event, displaying the winners and the amounts won from each pool. The ETGTs provide immediate feedback, including animations and notifications, showing the payout distribution.

### Data Storage and Reporting

The system logs all player contributions and jackpot events for auditing and reporting purposes. This data includes the total amount wagered by each player, their proportional contribution to each jackpot pool, and the final distribution of winnings when a jackpot is triggered.

### Error Handling and Security Measures

To ensure accurate contribution tracking and payout distribution, the system includes real-time error-checking mechanisms. If a discrepancy occurs in tracking player wagers or calculating contributions, the system flags the error and prevents payouts until the issue is resolved. Security measures are also in place to ensure that jackpot pools cannot be tampered with and that contributions are accurately logged.

### End of Interaction

Once a jackpot is triggered and the winnings are distributed, the system resets the jackpot pools, allowing new contributions to begin accumulating. Players are notified that the jackpot has been won, and the ETGTs reset the contribution trackers for the next game session.

### Innovative Concept 20: Randomly Increased Jackpot Prize

### Identification of Concept

The Randomly Increased Jackpot Prize introduces an element of surprise into the DETG experience by randomly increasing the jackpot amount by a certain percentage at various intervals. Unlike traditional jackpots that grow steadily based on player contributions, this concept injects random bonus increases into the jackpot pool, which may happen at any time during gameplay. The randomness of these increases keeps players engaged, as they never know when the jackpot may suddenly become more lucrative. This element of unpredictability adds excitement and encourages players to keep playing in hopes of catching the jackpot during one of these random boosts.

### Sequence Diagram Components

ETGTs: Player terminals where bets are placed, and players are notified of random jackpot increases.
Casino Network Servers: Track jackpot totals and randomly apply percentage increases to the jackpot pool.
Player A, Player B, etc.: Players contributing to the jackpot pool through their gameplay, hoping to win the enhanced prize.
Random Jackpot Boost Logic: Software responsible for determining when and by how much the jackpot pool will be increased, using random number generation (RNG).
Game Servers: Manage game state and jackpot tracking, communicating with the Casino Network Servers to update jackpot totals.

### Implementation Details

The Randomly Increased Jackpot Prize is implemented by introducing a Random Jackpot Boost Logic that periodically increases the jackpot pool by a randomly determined percentage. This boost may happen at any point during gameplay, without any specific player action triggering it. The randomness of the increase adds an extra layer of excitement, as players are constantly waiting for the jackpot to grow unexpectedly.

When the system triggers a random increase, it sends a notification to all ETGTs, informing players of the new jackpot total. The Casino Network Server tracks these increases, ensuring that the jackpot pool is updated correctly and the prize grows unpredictably.

### Example Walk-Through Scenario

Player A and Player B are both playing baccarat at DETG terminals, contributing to a shared jackpot pool through their regular bets. Midway through a game session, the Random Jackpot Boost Logic triggers a 20% increase to the current jackpot total. The ETGTs notify Player A, Player B, and all other players of the sudden increase in the jackpot, which immediately adds extra excitement to the ongoing game.

Players are now more motivated to continue betting, knowing that the jackpot has grown unexpectedly and may potentially be won at any moment. The random nature of the increase adds an element of surprise, driving further engagement as players attempt to win the enhanced prize.

### Player Interaction

Players interact with this system by participating in regular gameplay, with the added anticipation of random jackpot increases. The randomness of these increases adds a layer of unpredictability, encouraging players to stay engaged in the game for longer periods, hoping to witness or capitalize on a sudden jackpot boost.

When a random increase occurs, players are immediately notified via their ETGTs, which display the new jackpot total and highlight the unexpected boost. This keeps players excited and engaged, as they know that the prize may grow at any moment without warning.

### Distinguishing Innovative Concepts

The Randomly Increased Jackpot Prize is novel because it introduces an element of randomized jackpot growth into the DETG environment, where traditional jackpots are typically driven solely by player contributions. This randomness keeps players on edge, adding excitement and encouraging extended play as they anticipate the possibility of the jackpot growing unexpectedly.

Notable novel features include:
1. Random jackpot increases: The system randomly boosts the jackpot pool by a percentage, adding unpredictability to the prize growth.
2. Real-time player notifications: Players are notified immediately when the jackpot grows, keeping them engaged and motivated to continue playing.
3. RNG-driven jackpot boosts: The size and timing of the boosts are determined by random number generation, ensuring that the increases are unpredictable and not tied to specific gameplay events.

### Distinguishing Inventive Steps

1. RNG-based jackpot increase trigger: The system uses random number generation to determine when and by how much the jackpot will be increased.
2. Real-time jackpot pool updates: When a random increase is triggered, the system immediately updates the jackpot total across all connected ETGTs, ensuring transparency and excitement for all players.
3. Player engagement through unpredictability: The random nature of the increases adds a psychological element to the gameplay, encouraging players to remain engaged for longer periods in hopes of catching a sudden jackpot boost. This step leverages the unpredictability to maintain a high level of excitement and anticipation among players.

### 35 USC 101 Considerations

The Randomly Increased Jackpot Prize goes beyond abstract concepts by offering a specific technical improvement in the way jackpot pools are managed and displayed in DETG systems. The use of random number generation (RNG) to trigger unpredictable increases in the jackpot creates a new level of excitement and engagement. This innovative concept improves the underlying functionality of DETGs by providing a novel mechanism for dynamically adjusting jackpot values based on random events, rather than only player contributions. This randomness, combined with real-time notifications, integrates seamlessly into the casino gaming network, ensuring a more interactive and engaging player experience.

### Data Input

Wager data: As players place bets, their contributions are tracked as normal, with the system monitoring their input toward the jackpot pool.
RNG trigger data: The system uses random number generation to determine when a jackpot boost will occur and the percentage increase that will be applied to the current jackpot total.
Jackpot pool data: The current jackpot total is continuously updated, and the system applies the random increases to this value in real-time.

### Component Interactions and Procedural Steps

1. ETGTs receive player wager data and send it to the Casino Network Servers to track contributions to the jackpot pool.
2. The Random Jackpot Boost Logic runs continuously in the background, using RNG to determine when and how much to increase the jackpot.
3. When a random increase is triggered, the Casino Network Servers update the jackpot total and send the new value to all ETGTs in real-time, notifying players of the jackpot boost.
4. The system continues tracking player contributions after the boost, with the enhanced jackpot available for players to win.

### Data Processing

The system processes:
Wager data: It calculates player contributions to the jackpot pool in real time.
Random boost logic: The system uses random number generation to determine the timing and percentage of the boost. It applies this increase to the current jackpot total.
Real-time jackpot updates: The new jackpot total, including the random boost, is processed and displayed across all ETGTs as soon as the increase is triggered.

### Outputs and Responses

Players receive real-time notifications on their ETGTs when a random jackpot increase occurs. This includes visual and optionally auditory feedback that the jackpot pool has grown by a certain percentage, encouraging them to place more bets and stay engaged. The updated jackpot total is prominently displayed on all terminals, ensuring that players are fully aware of the increased potential winnings.

### Data Storage and Reporting

The system logs all random jackpot increases, including the time, percentage boost, and resulting new jackpot total. This data is stored for auditing and reporting purposes, providing a complete history of all jackpot changes. This allows casino operators to analyze the effectiveness of the random boosts in maintaining player engagement and maximizing revenue.

### Error Handling and Security Measures

The system includes error-checking mechanisms to ensure that random boosts are applied correctly and that the jackpot total is updated accurately across all ETGTs. If a discrepancy is detected in the jackpot value, the system triggers an alert and temporarily halts gameplay to resolve the issue. Security protocols are also in place to ensure that the RNG logic cannot be tampered with, protecting the integrity of the random boosts and preventing manipulation of the jackpot pool.

### End of Interaction

Once a random boost is applied and players are notified, gameplay continues as normal, with the enhanced jackpot now available for winning. The Random Jackpot Boost Logic resets for the next random increase, continuing to run in the background until the next boost is triggered. Players are aware that the jackpot may increase at any time, encouraging them to remain engaged and continue placing bets in anticipation of future boosts.

### Innovative Concept 21: Jackpot Sharing Among Players

### Identification of Concept

The Jackpot Sharing Among Players concept introduces a cooperative jackpot system where the jackpot winnings are distributed among multiple players based on their contributions or game participation. Instead of a single player winning the entire jackpot, this system allows for a more communal experience where the jackpot is shared proportionally among those who contributed or met certain gameplay criteria. This feature fosters a sense of community and collaboration among players and encourages more consistent participation, as players know they have a stake in the jackpot even if they are not the direct trigger of the event.

### Sequence Diagram Components

ETGTs: Terminals where players place their wagers and track their contributions toward the jackpot.
Casino Network Servers: Manage player contributions, track eligibility for jackpot sharing, and calculate the distribution of winnings.
Player A, Player B, etc.: Multiple players contributing to the jackpot pool, with each player's potential share determined by their wager amounts or other factors.
Jackpot Distribution Logic: Software responsible for determining the proportions of the jackpot each player is entitled to, based on their participation and contributions.

### Implementation Details

In this system, each player's contributions to the jackpot pool are tracked by the Casino Network Server throughout the game session. When the jackpot is triggered, the Jackpot Distribution Logic calculates how much of the jackpot each player is entitled to, based on their total contributions or participation in certain rounds. This may be as simple as distributing the jackpot based on the percentage of total wagers placed by each player, or it may involve more complex criteria such as rewarding players for consistent participation or hitting certain in-game milestones.

Once the distribution is calculated, the jackpot is split among the eligible players, with the winnings automatically added to each player's balance. The system may be configured to adjust the distribution logic based on casino preferences, allowing for flexible payout structures that suit different game types and player demographics.

### Example Walk-Through Scenario

At a blackjack table, Player A and Player B are both participating in the same jackpot pool, placing wagers over the course of several rounds. Throughout the game, Player A has contributed more to the jackpot pool due to placing higher bets, while Player B has placed smaller, but consistent, wagers.

When the jackpot is triggered, the system calculates that Player A is entitled to 70% of the jackpot, based on their larger contributions, while Player B receives 30%. Both players are notified of their share of the jackpot via the ETGTs, and the winnings are immediately credited to their accounts. This cooperative distribution allows both players to feel rewarded, even though only one of them may have triggered the actual jackpot event.

### Player Interaction

Players participate in this system by placing wagers as usual, with their contributions to the jackpot pool tracked automatically by the system. The ETGTs display real-time information about each player's current share of the jackpot, based on their contributions or participation in the game. This interaction fosters a sense of teamwork, as players know that they will receive a portion of the jackpot even if they are not the direct trigger.

Players are encouraged to place consistent bets or contribute larger amounts to increase their share of the jackpot, creating an additional layer of strategy to their gameplay. The cooperative nature of this system also helps sustain player engagement, as all participants are invested in the outcome of the jackpot event.

### Distinguishing Innovative Concepts

The Jackpot Sharing Among Players concept stands out because it introduces a cooperative element to the typically competitive nature of jackpot systems. By distributing winnings among multiple players, this concept encourages collaboration and sustained participation.

Notable novel features include:
1. Proportional jackpot sharing: Players are rewarded based on their contributions or participation, allowing multiple players to benefit from the jackpot event.
2. Real-time tracking of contributions: The system continuously tracks each player's share of the jackpot, providing transparency and fostering a communal gaming experience.
3. Flexible distribution logic: The system may be configured to distribute winnings based on a variety of factors, such as total wager amounts, participation frequency, or in-game achievements.

### Distinguishing Inventive Steps

1. Player contribution tracking: The system monitors and records each player's wager contributions to the jackpot pool in real time, calculating their potential share.
2. Dynamic jackpot distribution: When the jackpot is triggered, the system dynamically allocates winnings among all eligible players based on their contributions or participation.
3. Real-time feedback: The ETGTs provide continuous updates to players on their current share of the jackpot, keeping them informed and engaged throughout the game.

### 35 USC 101 Considerations

The Jackpot Sharing Among Players concept enhances the functionality of traditional DETG jackpot systems by introducing a cooperative payout mechanism. This system improves player engagement by rewarding multiple players based on their contributions, offering a practical and non-abstract solution to enhance the player experience. The technical implementation—tracking contributions, dynamically distributing payouts, and providing real-time feedback—creates a tangible improvement over conventional jackpot systems, ensuring that the innovation integrates into the DETG network in a way that promotes communal interaction.

### Data Input

Wager data: The system tracks each player's wagers and calculates their contribution to the jackpot pool in real time.
Player participation data: The system may also track other factors, such as the number of rounds a player has participated in, to determine eligibility for jackpot sharing.
Jackpot distribution criteria: The system uses predefined criteria to calculate how the jackpot will be split among eligible players, adjusting these parameters based on game type or casino preferences.

### Component Interactions and Procedural Steps

1. Players place wagers via ETGTs, and each wager contributes to the jackpot pool, tracked by the Casino Network Servers.
2. The Jackpot Distribution Logic continuously monitors each player's contribution, calculating their potential share of the jackpot in real time.
3. When the jackpot is triggered, the Casino Network Servers retrieve each player's contribution data and apply the distribution criteria.
4. The system dynamically allocates the jackpot, dividing the total prize among the eligible players based on their respective contributions or participation.
5. The winnings are credited to the players' accounts, and the ETGTs notify each player of their portion of the jackpot, providing real-time feedback on the payout.

### Data Processing

The system processes wager data from each player and applies it to their respective share of the jackpot pool. Additionally, the Jackpot Distribution Logic continuously calculates each player's share based on the pre-set distribution criteria, ensuring that the jackpot is fairly split among eligible participants. When the jackpot is triggered, the system computes the final distribution, factoring in contributions, participation, or other criteria.

### Outputs and Responses

The ETGTs provide real-time updates to players, displaying their current contribution to the jackpot and their potential share. When the jackpot is triggered, each player receives an immediate notification on their terminal, showing the amount they won based on their contributions. This transparent feedback encourages player engagement, making the cooperative nature of the jackpot distribution clear and rewarding for all participants.

### Data Storage and Reporting

The system logs all player contributions, jackpot triggers, and distribution events for auditing and reporting purposes. This data is stored on the Casino Network Servers, providing a comprehensive record of how the jackpot was accumulated and distributed. These logs may be used for performance analysis, ensuring fairness and identifying trends in player behavior.

### Error Handling and Security Measures

The system includes error-checking mechanisms to ensure that contributions are correctly tracked and that jackpot distribution is calculated accurately. If a discrepancy is detected in a player's contribution or the jackpot allocation, the system flags the issue and temporarily halts distribution until the error is resolved. Additionally, robust security protocols ensure that only authorized casino personnel may alter the jackpot distribution logic or parameters, preventing tampering or manipulation.

### End of Interaction

Once the jackpot is distributed, the system resets the jackpot pool and the contribution trackers. Players are informed that the next jackpot cycle is beginning, allowing them to start accumulating contributions again. The system maintains a loop where each jackpot event provides an exciting and cooperative experience, with the potential for multiple winners across different game sessions.

### Innovative Concept 22: Player-Specific Jackpot Reward Customization

### Identification of Concept

The Player-Specific Jackpot Reward Customization concept allows players to personalize their jackpot rewards by selecting or unlocking different types of prizes based on their preferences or play history. Instead of receiving a standard jackpot payout, players may choose from a variety of reward options, such as cash, free play credits, VIP experiences, or physical prizes (e.g., luxury items, vacation packages). This system is tailored to individual player preferences and behaviors, offering a customized reward experience that enhances player engagement and loyalty. The personalized nature of the rewards adds an extra level of excitement, as players feel more connected to the game and the casino.

### Sequence Diagram Components

ETGTs: Terminals where players engage in gameplay and select or unlock customized jackpot rewards based on their achievements or contributions.
Casino Network Servers: Store player preferences, track their jackpot contributions, and manage the customization options available to each player.
Player A, Player B, etc.: Players interacting with the system by earning and selecting personalized jackpot rewards.
Reward Customization Logic: Software responsible for presenting reward options to players, tracking their selections, and managing the delivery of personalized rewards.
Player Tracking Systems: Monitor player activity and preferences, integrating with the reward system to offer tailored reward choices based on individual behaviors and history.

### Implementation Details

The Player-Specific Jackpot Reward Customization system is implemented by integrating player tracking data with the jackpot reward system. Each player's preferences and gameplay history are stored in the Player Tracking System, which allows the Reward Customization Logic to present tailored reward options whenever a jackpot is triggered. These options may include a mix of traditional cash payouts, bonus credits, physical rewards, or unique experiences, such as VIP access to events or exclusive casino services.

When a player wins a jackpot, they are prompted to select their preferred reward via their ETGT. The system displays a list of available rewards, which may be customized based on the player's past activity, VIP status, or preferences stored in the casino's tracking system. Once the player makes a selection, the system processes the reward and updates their player profile accordingly.

### Example Walk-Through Scenario

Player A, a high-roller with VIP status, wins a mystery jackpot while playing a game of baccarat at a DETG terminal. When the jackpot is triggered, Player A's ETGT displays several reward options, including a cash payout, bonus credits, and an exclusive luxury watch. Because Player A has consistently shown a preference for luxury goods and has a high VIP level, the system offers a tailored selection of high-end rewards.

Player A chooses the luxury watch as their jackpot reward. The system processes this selection, deducts the cost of the watch from the jackpot pool, and arranges for the reward to be delivered to Player A. Simultaneously, Player A's player profile is updated, showing that they have redeemed a high-value reward, which contributes to their ongoing VIP benefits.

### Player Interaction

Players interact with this system by selecting personalized jackpot rewards through their ETGT terminals after winning. The system offers a variety of reward choices, which may differ based on each player's preferences, spending habits, and VIP status. This interaction empowers players to tailor their experience, choosing the rewards that best suit their desires.

In addition to engaging with the system after a jackpot win, players are encouraged to interact with the Player Tracking System to update their preferences and unlock more valuable or exclusive rewards. This ongoing engagement builds loyalty and motivates players to continue playing in hopes of earning their desired rewards.

### Distinguishing Innovative Concepts

The Player-Specific Jackpot Reward Customization system is unique because it allows players to customize their rewards, making the jackpot experience more personal and engaging. Traditional jackpot systems offer fixed prizes, while this concept tailors the rewards to the individual, increasing player satisfaction and loyalty.

Notable novel features include:
1. Customized reward options: Players may select from a variety of rewards, ensuring that their winnings are aligned with their preferences and gaming habits.
2. Integration with player tracking systems: The system uses player data to present tailored reward options, offering a personalized experience that enhances engagement.
3. Flexible reward management: Casinos may adjust the available reward options based on player behavior, inventory, or promotional goals, making the system highly adaptable to different player segments.

### Distinguishing Inventive Steps

1. Player preference tracking: The system continuously monitors each player's preferences and behavior to offer personalized reward options when a jackpot is triggered.
2. Dynamic reward selection: Upon winning a jackpot, players are presented with a selection of rewards that are tailored to their play history, preferences, or VIP status.
3. Reward fulfillment and profile updating: Once a reward is selected, the system processes the prize and updates the player's profile, ensuring that future interactions consider the player's previous choices and preferences.

### 35 USC 101 Considerations

The Player-Specific Jackpot Reward Customization system introduces a tangible improvement over traditional jackpot systems by integrating player data to offer a customized reward experience. This innovative concept goes beyond an abstract idea by solving the problem of generic rewards in jackpot systems, offering a practical, personalized solution that enhances player engagement and loyalty. The system improves the underlying functionality of DETGs by providing a tailored, dynamic reward experience that integrates directly with player tracking systems, adding real-world value and differentiation to the gameplay experience.

### Data Input

Player tracking data: The system gathers data on player preferences, VIP status, and gameplay behavior to offer tailored reward options.
Wager data: The system tracks each player's contributions to the jackpot pool, which may influence the types of rewards they are eligible to select.
Reward inventory data: The system manages the available rewards, ensuring that only valid and in-stock prizes are presented to the player.

### Component Interactions and Procedural Steps

1. Player tracking systems send player data to the Casino Network Servers, which store individual preferences, game history, and VIP status.
2. When a jackpot is triggered, the Reward Customization Logic presents a list of tailored reward options on the player's ETGT.
3. The player selects their preferred reward, and the system processes the prize, updating their player profile to reflect the selection.
4. The system arranges for the fulfillment of the reward, whether it be a cash payout, bonus credits, or a physical prize.

### Data Processing

The system processes player data to determine which rewards are most appropriate based on the individual's preferences, VIP level, and gaming behavior. Additionally, the system processes reward inventory data to ensure that only available rewards are presented. After the player selects their reward, the system updates their profile and tracks the reward fulfillment process.

### Outputs and Responses

Players receive personalized reward options on their ETGTs when they win a jackpot. After selecting a reward, the system immediately confirms the selection and arranges for the prize to be delivered or credited to the player's account. Players also receive updates on their profile, showing how their selection impacts their VIP status or future rewards.

### Data Storage and Reporting

The system logs all player interactions with the reward customization system, including their preferences, selected rewards, and jackpot contributions. This data is stored on the Casino Network Servers for auditing, performance analysis, and reporting. The casino may use this data to assess player engagement with the reward system, track the popularity of different reward types, and optimize the available inventory for future promotions. Additionally, the logs provide a record of player interactions that may be used to resolve disputes or verify reward fulfillment.

### Error Handling and Security Measures

The system incorporates error-checking mechanisms to ensure that rewards are accurately displayed and that only eligible players may select certain options. If there is an issue with reward availability, such as inventory errors or system discrepancies, the player is notified, and the system recalibrates the available options in real time. Security measures ensure that the Player Tracking System and Reward Customization Logic are protected from tampering, and that only authorized personnel may alter reward availability or player profiles.

Additionally, if a player is disconnected during the reward selection process, the system saves their progress and allows them to resume where they left off once reconnected.

### End of Interaction

Once the player has selected and received their customized jackpot reward, the system updates their profile, logging the prize and any relevant player history. The system prepares for future interactions by adjusting the available reward options based on the player's selection, ensuring that they receive fresh and relevant options during future jackpots. The system then resets for the next jackpot event, ready to present personalized rewards to the next eligible player.

The player is notified that their selection has been processed, and their profile reflects any changes related to their VIP status, ongoing promotions, or rewards that have been redeemed. This creates a continuous cycle of engagement where players are motivated to return for more personalized rewards in the future.

### Innovative Concept 23: Multi-Stage Jackpot Challenge

### Identification of Concept

The Multi-Stage Jackpot Challenge introduces a competitive, tiered system where players must complete multiple stages of challenges or game milestones to unlock different levels of jackpot prizes. This concept transforms the typical jackpot system into a progressive, skill-based experience where each stage offers increasingly valuable rewards. Players must complete a set of objectives (e.g., winning consecutive hands, placing bets of increasing amounts, or achieving specific in-game outcomes) to progress to the next stage, with the final jackpot only available upon completion of the ultimate challenge.

This multi-stage approach provides a unique blend of skill and chance, keeping players engaged for extended periods as they work toward unlocking the highest jackpot tier.

### Sequence Diagram Components

ETGTs: Player terminals where participants track their progress through the various stages of the jackpot challenge.
Casino Network Servers: Manage player progress, track completed challenges, and trigger the next stage of the jackpot challenge.
Player A, Player B, etc.: Players engaging in the multi-stage jackpot challenge, advancing through tiers based on their in-game performance.
Stage Progression Logic: Software that tracks player achievements and determines when they have met the criteria to advance to the next stage.
Challenge Milestones: Predefined objectives that players must meet to progress through the challenge tiers.

### Implementation Details

In this system, players participate in the Multi-Stage Jackpot Challenge by completing specific game-related objectives that advance them through multiple stages of increasing difficulty and reward. For example, the first stage may require players to win three consecutive rounds of blackjack or place a series of bets that meet certain criteria. Once a player completes the challenge for a stage, they advance to the next, with each successive stage offering more substantial rewards.

The Stage Progression Logic tracks each player's progress through the stages, updating the Casino Network Servers with completed milestones and triggering the next stage once the player qualifies. Players are informed of their progress via real-time notifications on their ETGTs, which display their current stage, the remaining objectives needed to advance, and the potential rewards for completing each stage.

Each stage culminates in a jackpot prize, but only the final stage offers the highest-tier jackpot. This multi-stage structure encourages long-term engagement, as players are motivated to continue playing to unlock the highest rewards.

### Example Walk-Through Scenario

Player B begins playing a multi-stage jackpot challenge at a DETG terminal. The first stage of the challenge may require Player B to place five consecutive bets of increasing amounts within a specific time frame. Player B successfully meets this requirement and advances to stage two, which may require them to win three consecutive rounds of baccarat.

Throughout the challenge, Player B's progress is tracked by the Stage Progression Logic, and they are notified each time they complete a milestone. By the time Player B reaches the final stage, they are competing for the grand jackpot, which is significantly larger than the rewards offered at the previous stages.

If Player B successfully completes the final challenge, they win the grand jackpot, which is immediately credited to their account. Even if they fail to complete the final challenge, they still retain the rewards from earlier stages, ensuring that the effort is partially rewarded.

### Player Interaction

Players interact with this system by tracking their progress through each stage of the jackpot challenge via their ETGTs. Each terminal provides real-time feedback on the player's current stage, what objectives need to be completed, and the potential rewards for advancing. This interaction creates a highly engaging experience, as players must actively work toward completing the objectives to unlock the jackpot.

The multi-stage format also introduces a layer of strategy, as players must decide how best to achieve the milestones while balancing their gameplay choices. The sense of progression keeps players invested over extended play sessions, as each new stage presents an opportunity to win larger rewards.

### Distinguishing Innovative Concepts

The Multi-Stage Jackpot Challenge introduces a novel approach to jackpot systems by turning them into a tiered, objective-based challenge rather than relying solely on random outcomes or cumulative contributions. This skill-based structure adds a new dimension to the gameplay, giving players more control over their progression and increasing the emotional investment in the game.

Notable novel features include:
1. Tiered jackpot stages: Players must complete multiple stages, each with unique challenges and increasingly valuable rewards, culminating in the grand jackpot.
2. Challenge-based progression: Players advance by completing specific milestones, which adds a strategic and skill-based element to the traditional jackpot format.
3. Real-time tracking and feedback: The system provides continuous updates on player progress, encouraging engagement and ensuring that players stay motivated to reach the final stage.

### Distinguishing Inventive Steps

1. Stage-based progression logic: The system tracks player progress through multiple challenge stages, advancing them only when the predefined objectives are met.
2. Dynamic challenge updates: The system dynamically adjusts the objectives for each stage based on the player's performance, ensuring that the challenge remains engaging and tailored to their skill level.
3. Incremental rewards: Each stage offers incremental rewards, with players receiving payouts for every stage they complete, even if they fail to reach the final jackpot stage.

### 35 USC 101 Considerations

The Multi-Stage Jackpot Challenge presents a specific technical improvement over conventional jackpot systems by introducing a structured, skill-based challenge that players must complete to unlock the jackpot. This innovative concept integrates a series of milestones and objectives into the DETG system, providing a more engaging and strategic gameplay experience. The system's integration of real-time tracking, dynamic progression, and tiered rewards offers a practical solution to the problem of maintaining player engagement over long sessions, transforming the traditional jackpot into a competitive and skill-driven event.

### Data Input

Wager data: The system tracks each player's bets and game outcomes to determine whether they meet the criteria for advancing to the next stage.
Challenge milestone data: Each stage has predefined objectives that the system uses to evaluate player progress and trigger stage completion.
Player progress data: The system continuously monitors each player's progress through the stages, updating their status as they complete milestones.

### Component Interactions and Procedural Steps

1. Players engage in gameplay via ETGTs, with each round contributing to the completion of the challenge objectives.
2. The Stage Progression Logic monitors player actions, tracking their progress toward completing each stage.
3. Once a stage is completed, the system updates the Casino Network Servers and advances the player to the next stage.
4. The system provides real-time feedback on the player's progress and the rewards available at each stage.

### Data Processing

The system processes wager data and game results to determine whether players have met the criteria for each stage of the jackpot challenge. It continuously tracks player progress through the stages, applying the Stage Progression Logic to update their status and trigger new objectives. The system also handles reward distribution for each stage, ensuring that players receive incremental payouts as they progress.

### Outputs and Responses

Players receive real-time notifications on their ETGTs each time they complete a stage or reach a milestone. The system provides updates on the current stage, the objectives for the next stage, and the potential rewards available. Once a player reaches the final stage, the system alerts them to the grand jackpot opportunity, increasing anticipation and engagement.

### Data Storage and Reporting

The system stores all player interactions with the multi-stage challenge, including their progress through each stage, completed milestones, and rewards earned. This data is logged for auditing purposes and may be used to evaluate the performance of the jackpot challenge, adjust the difficulty of the stages, or tailor the experience to different player segments.

### Error Handling and Security Measures

The system includes error-checking mechanisms to ensure that player progress is accurately tracked and that rewards are distributed correctly at each stage. If an error occurs in tracking player achievements or advancing to the next stage, the system pauses the challenge and alerts casino operators to investigate the issue. Security measures ensure that the Stage Progression Logic and reward distribution processes cannot be tampered with, maintaining the integrity of the multi-stage jackpot challenge. If a player encounters a network issue or disconnection during a stage, the system saves their progress, allowing them to resume the challenge without losing any completed milestones. Additionally, the system monitors for any discrepancies between wager data and stage completion, ensuring that players are only advanced once all conditions are met.

### End of Interaction

Once a player reaches the final stage and either wins the grand jackpot or fails to complete the last challenge, the system resets their progress and prepares for the next challenge session. Any rewards earned from previous stages are credited to the player's account, ensuring that partial progress is rewarded even if the ultimate jackpot is not won. The system resets for the next player or session, ready to track new participants through the multi-stage process.

This structure provides continuous engagement, as players are encouraged to re-enter the challenge for another chance at the grand jackpot, while still benefiting from the incremental rewards earned along the way.

### Innovative Concept 24: Jackpot Prize Pool Based on Player Game Metrics

### Identification of Concept

The Jackpot Prize Pool Based on Player Game Metrics concept dynamically adjusts the size of the jackpot prize pool based on individual player performance metrics during gameplay. These metrics may include factors such as bet size, win/loss ratios, consecutive wins, and other performance-related data. Instead of a fixed jackpot amount, the system rewards players with a jackpot pool that grows in proportion to their skill level, consistency, or engagement in the game. This creates a personalized experience, as each player's contribution to the jackpot is influenced by their performance, leading to a more dynamic and engaging system.

### Sequence Diagram Components

ETGTs: Terminals where players place their bets and track their in-game performance metrics.
Casino Network Servers: Track player performance data and adjust the size of the jackpot pool accordingly.
Player A, Player B, etc.: Players whose gameplay data (such as win/loss ratios, bet amounts, and consecutive wins) are used to dynamically adjust the jackpot prize pool.
Game Metrics Tracking Logic: Software that monitors player performance metrics in real time and calculates the contribution to the jackpot prize pool based on these metrics.
Jackpot Prize Pool Management System: Manages the overall size and distribution of the jackpot based on the aggregated player metrics and performance thresholds.

### Implementation Details

In this system, the Game Metrics Tracking Logic monitors individual player metrics during gameplay, tracking data such as bet amounts, win streaks, loss streaks, and game efficiency. These metrics are fed into the Casino Network Servers, which dynamically adjust the size of the jackpot pool based on the player's performance. For example, a player who consistently places higher bets or wins consecutive rounds may contribute more significantly to the growth of the jackpot pool, while players with lower bet amounts or fewer wins contribute proportionally less.

The system incentivizes high engagement and skillful play, rewarding players who perform well by increasing their share of the potential jackpot. This approach contrasts with traditional fixed-jackpot systems by making the jackpot outcome more dependent on player interaction and performance. Players may monitor their impact on the jackpot pool in real time, with the ETGTs providing feedback on how their current game session is affecting the overall jackpot size.

### Example Walk-Through Scenario

Player A begins playing blackjack on a DETG and consistently places high bets while achieving a win streak of five consecutive rounds. As Player A's performance improves, the Game Metrics Tracking Logic recognizes these accomplishments and increases Player A's contribution to the overall jackpot pool. Simultaneously, Player B, who is placing smaller bets and not performing as well, contributes a lower amount to the jackpot.

Both players may see their individual contributions to the jackpot on their ETGTs, with Player A's increased performance reflected in a larger potential payout if they win the jackpot. The dynamic nature of the jackpot pool encourages both players to stay engaged, as they may directly see how their performance is influencing the size of the prize.

### Player Interaction

Players interact with the system through their ETGTs, where they may monitor how their gameplay metrics (such as bet size, win/loss ratio, and streaks) are contributing to the growth of the jackpot pool. The system encourages more strategic and skillful play, as players who perform well are rewarded with a larger potential share of the jackpot.

This interaction also adds a layer of personalization, as each player's contributions to the jackpot pool vary based on their individual performance. Players are motivated to improve their gameplay and maintain high engagement, knowing that their efforts directly impact the jackpot prize they may potentially win.

### Distinguishing Innovative Concepts

The Jackpot Prize Pool Based on Player Game Metrics concept introduces a dynamic jackpot system where the prize pool is directly influenced by player performance, rather than being solely dependent on fixed contributions or random outcomes.

Notable novel features include:
1. Performance-based jackpot growth: The size of the jackpot pool increases or decreases based on individual player performance metrics, such as bet size and win streaks.
2. Real-time feedback: Players receive real-time updates on how their gameplay is impacting the jackpot pool, fostering a more engaging and personalized experience.
3. Incentive for skillful play: The system encourages players to focus on improving their game, knowing that their performance directly impacts the potential jackpot payout.

### Distinguishing Inventive Steps

1. Real-time performance tracking: The system continuously monitors player performance metrics and dynamically adjusts the jackpot pool based on these data points.
2. Dynamic jackpot contribution calculation: Unlike traditional fixed jackpots, the system calculates contributions to the jackpot based on player performance, making each player's share of the jackpot unique.
3. Personalized jackpot potential: Each player's potential winnings are influenced by their performance, offering a more tailored and motivating gameplay experience.

### 35 USC 101 Considerations

The Jackpot Prize Pool Based on Player Game Metrics concept provides a concrete, practical improvement to conventional jackpot systems by integrating real-time player performance tracking into the calculation of jackpot contributions. This inventive system goes beyond an abstract idea by addressing the problem of fixed, one-size-fits-all jackpots and offering a dynamic, personalized solution that rewards skill and engagement. The technical implementation leverages real-time data processing and personalized feedback to create a more interactive and engaging gameplay experience, advancing the functionality of DETG systems.

### Data Input

Player performance metrics: The system tracks individual player metrics such as bet size, win/loss ratios, consecutive wins, and overall engagement.
Wager data: Each player's wager amounts are monitored in real time to calculate their contribution to the jackpot pool.
Game state data: The system tracks each player's progress and updates the jackpot pool based on performance milestones and outcomes.

### Component Interactions and Procedural Steps

1. ETGTs record player bets and performance metrics and send this data to the Casino Network Servers.
2. The Game Metrics Tracking Logic processes player data in real time, calculating each player's contribution to the jackpot pool based on their performance.
3. The Jackpot Prize Pool Management System adjusts the overall jackpot size dynamically as more players contribute, and performance metrics influence the pool.
4. Players are notified via their ETGTs of how their performance has influenced the jackpot pool and their potential share of the prize.

### Data Processing

The system processes wager data and performance metrics from each player, dynamically adjusting their contribution to the jackpot pool based on their game performance. The system continuously updates the jackpot pool size as players' metrics change, providing real-time feedback to ensure a dynamic and responsive gaming experience.

### Outputs and Responses

Players receive real-time notifications on their ETGTs that show how their performance metrics are impacting the jackpot pool. The system also displays the overall size of the jackpot and each player's potential share, keeping players engaged and motivated to continue playing to maximize their potential winnings.

### Data Storage and Reporting

The system logs all player contributions, performance metrics, and jackpot pool changes for auditing and reporting purposes. This data is stored on the Casino Network Servers and may be used to analyze player behavior, optimize game performance, and ensure fairness in jackpot distribution.

### Error Handling and Security Measures

The system includes error-checking mechanisms to ensure that player metrics and contributions are accurately tracked and that jackpot pool adjustments are made correctly. If a discrepancy occurs in tracking performance data or calculating contributions, the system flags the issue for review and temporarily halts adjustments to the jackpot pool. Security protocols ensure that only authorized personnel may modify the performance tracking criteria or jackpot pool distribution rules.

### End of Interaction

Once the jackpot is triggered and the prize pool is distributed, the system resets the performance metrics and jackpot contributions for the next game session. Players are notified of their final contributions and winnings, and the system prepares for the next round of gameplay. The dynamic nature of this jackpot system ensures that each new session provides a fresh and personalized experience for players.

### Innovative Concept 25: Jackpot Tiers Based on Bet Levels

### Identification of Concept

The Jackpot Tiers Based on Bet Levels concept introduces a jackpot system with multiple tiers, where each tier corresponds to a different level of bet size. Players who place higher bets contribute to and compete for higher-tier jackpots, while those placing smaller bets contribute to lower-tier jackpots. This system provides an inclusive experience by allowing players at all bet levels to participate in jackpots while incentivizing higher-stake play with progressively larger jackpots at the upper tiers.

The system ensures that players at different levels of risk and reward have proportional opportunities to win, promoting engagement across various player segments. This tiered structure is designed to enhance player satisfaction by providing a range of potential payouts based on the player's betting strategy and risk tolerance.

### Sequence Diagram Components

ETGTs: Electronic terminals where players place wagers and contribute to the appropriate jackpot tier based on their bet amount.
Casino Network Servers: Track each player's bets, assign them to the appropriate jackpot tier, and manage the contribution and distribution of each jackpot pool.
Player A, Player B, etc.: Players contributing to and participating in different jackpot tiers based on their bet levels.
Jackpot Tier Management Logic: Software that dynamically assigns players to different jackpot tiers and manages the size of each pool.
Jackpot Display: Visual indicators on ETGTs showing players which tier they are contributing to and the current prize pool for each tier.

### Implementation Details

The Jackpot Tiers Based on Bet Levels system operates by categorizing players into different jackpot tiers based on the size of their wagers. For instance:
Low-tier: Small wagers (e.g., $1-$10) contribute to a smaller jackpot.
Mid-tier: Medium-sized wagers (e.g., $11-$50) contribute to a larger jackpot pool.
High-tier: Large wagers (e.g., $51+) contribute to the largest jackpot pool.

Each ETGT communicates with the Casino Network Server, which tracks the player's bet size and automatically places them in the appropriate jackpot tier. The Jackpot Tier Management Logic ensures that players may only win from the tier they are contributing to, and the system updates the jackpot prize pool for each tier in real time.

Players are notified via their ETGT of their current tier and may see the size of the potential jackpot they are eligible to win. This setup encourages players to increase their wagers to move up to higher tiers, where larger jackpots are available.

### Example Walk-Through Scenario

Player A places a $10 bet at a DETG terminal, which qualifies them for the low-tier jackpot. Player B, at a different terminal, places a $60 bet, qualifying for the high-tier jackpot. As both players continue to play, their bets are tracked and contribute to their respective jackpot tiers.

Throughout the game, Player A sees that the low-tier jackpot has accumulated to $1,000, while Player B sees that the high-tier jackpot has grown to $10,000. Both players are eligible to win their respective jackpots, but Player B's potential reward is much higher due to their larger bet size and contribution to the higher-tier pool.

When the jackpot is triggered, Player B wins the high-tier jackpot, taking home the $10,000 prize, while Player A remains in the low-tier pool, waiting for their chance to win the $1,000 prize. The system resets the jackpot pools for the next game, and the tier structure continues.

### Player Interaction

Players interact with the Jackpot Tiers Based on Bet Levels system through their bet amounts, which automatically determine their jackpot tier. The ETGTs provide real-time feedback on the current size of each jackpot tier and inform players of which tier they are contributing to based on their bet size.

This interaction allows players to strategize their wagers. For example, a player may place smaller bets to stay within a lower-tier jackpot for more frequent but smaller wins, or they may increase their bet size to compete for the higher-tier jackpots with larger rewards. This tiered approach encourages diverse play styles while offering opportunities for all players to participate in a jackpot, regardless of their bet size.

### Distinguishing Innovative Concepts

The Jackpot Tiers Based on Bet Levels concept introduces a tiered jackpot system that dynamically adjusts based on player wager amounts. This structure provides several advantages:
1. Proportional jackpots: Players at all betting levels have access to jackpots that are proportional to their wager sizes, creating a fair and balanced system.
2. Incentive for higher stakes: Higher-tier jackpots incentivize players to increase their bets, fostering greater player engagement and excitement.
3. Multiple jackpot opportunities: The tiered system allows for multiple jackpots to be available at once, giving players at different tiers the opportunity to win simultaneously.

### Distinguishing Inventive Steps

1. Dynamic tier assignment: The system dynamically assigns players to different jackpot tiers based on their bet amounts, ensuring that players only contribute to and compete for jackpots that match their level of risk.
2. Real-time jackpot pool updates: Each tier's jackpot pool is updated in real time as players place bets, providing instant feedback on the potential rewards available at each level.
3. Multiple simultaneous jackpots: The system may handle multiple jackpots at once, allowing players at different tiers to win jackpots independently of one another.

### 35 USC 101 Considerations

The Jackpot Tiers Based on Bet Levels concept offers a technical improvement over traditional jackpot systems by introducing a tiered structure that dynamically adjusts based on player wager amounts. This system integrates real-time data tracking, dynamic tier assignment, and multi-tiered jackpot management, addressing the problem of one-size-fits-all jackpots and providing a more personalized and engaging experience. The practical application of this system improves the functionality of DETGs by creating a flexible, tiered jackpot environment that enhances player participation and excitement.

### Data Input

Wager data: The system tracks the size of each player's bet and uses this data to assign them to the appropriate jackpot tier.
Jackpot pool data: Each jackpot pool is dynamically updated based on player contributions within their assigned tier.
Game state data: The system monitors the progress of the game and tracks which players are contributing to which jackpot tier.

### Component Interactions and Procedural Steps

1. Players place bets on their ETGTs, and the Casino Network Servers track the bet size to assign them to the appropriate jackpot tier.
2. The Jackpot Tier Management Logic dynamically adjusts the jackpot pools for each tier based on the cumulative contributions of players in that tier.
3. The ETGTs display real-time information about the size of the jackpot in the player's tier and notify them when the jackpot is won.
4. When a jackpot is triggered, the system calculates the winning amount based on the tier and distributes the payout to the eligible player(s).

### Data Processing

The system processes wager data to assign players to the correct jackpot tier and updates the respective jackpot pools based on player contributions. The system also processes game outcomes to determine when a jackpot is triggered and calculates the appropriate payout for the winning tier.

### Outputs and Responses

Players receive real-time notifications on their ETGTs showing their current jackpot tier, the size of the prize pool, and any updates to the jackpot as it grows. When a jackpot is won, the system notifies the winning player(s) and resets the jackpot pools for the next round of play.

### Data Storage and Reporting

The system logs all player bets, tier assignments, and jackpot contributions for auditing and reporting purposes. This data is stored on the Casino Network Servers and may be used to analyze player behavior, optimize the tier structure, and ensure that jackpots are distributed fairly and transparently.

### Error Handling and Security Measures

The system includes error-checking mechanisms to ensure that players are assigned to the correct jackpot tier based on their bets. If there is a discrepancy in a player's tier assignment or a miscalculation of the jackpot pool, the system flags the issue and temporarily pauses the game to resolve the error. Security protocols ensure that only authorized personnel may modify tier thresholds or jackpot distribution rules.

### End of Interaction

Once a jackpot is triggered and distributed, the system resets the jackpot pools for each tier and prepares for the next round of contributions. Players are notified of the jackpot reset, and the system continues tracking bets and tier assignments in real time. This tiered system encourages ongoing player engagement, as players know they may compete for jackpots that match their betting strategy and risk tolerance.

### Innovative Concept 26: Jackpot Activated by Hidden Milestones

### Identification of Concept

The Jackpot Activated by Hidden Milestones concept introduces a jackpot system where the trigger for winning is not based solely on bet amounts or game outcomes but on reaching hidden gameplay milestones. These milestones are unknown to the players and are revealed only once they have been achieved. Milestones may include completing a certain number of consecutive wins, reaching a cumulative bet total over multiple rounds, or achieving specific in-game actions such as hitting a rare combination of cards in blackjack.

This system adds an element of mystery and surprise to the jackpot structure, as players are unaware of exactly when or how they may trigger the jackpot, which increases engagement and excitement.

### Sequence Diagram Components

ETGTs: Player terminals where players engage in gameplay and attempt to reach the hidden milestones.
Casino Network Servers: Track player progress toward the hidden milestones, monitoring in-game actions, bet amounts, and outcomes.
Player A, Player B, etc.: Players who unknowingly work toward reaching the hidden milestones while engaging in normal gameplay.
Milestone Tracking Logic: Software that monitors each player's actions during gameplay, including bet sizes, win/loss ratios, and specific in-game events to track progress toward the hidden milestones that trigger the jackpot.
Casino Display System: Communicates to players when they have unknowingly met a hidden milestone, displaying jackpot triggers or progress alerts at appropriate moments.

### Implementation Details

The Jackpot Activated by Hidden Milestones system is designed to introduce mystery and surprise into the jackpot process. As players engage in regular gameplay, the Milestone Tracking Logic monitors specific conditions that are tied to hidden milestones. These milestones may include:
Achieving consecutive wins over a specific number of rounds.
Reaching a cumulative bet total (e.g., wagering $1,000 across multiple rounds).
Accomplishing rare in-game events, such as drawing a specific hand in blackjack or landing a particular combination in baccarat.

Players are unaware of these milestone criteria during play, creating an element of surprise when the jackpot is triggered. The Casino Network Servers continuously monitor each player's progress and notify them when a milestone is achieved, triggering the jackpot.

The ETGTs provide real-time feedback when players meet hidden milestones, displaying animations and notifications that reveal the achievement and the subsequent jackpot win. This system keeps players engaged by adding a layer of mystery to the gameplay, encouraging extended play in the hope of unknowingly unlocking a jackpot.

### Example Walk-Through Scenario

Player A is playing a round of blackjack on a DETG, completely unaware that the system is tracking their cumulative bet amount. After several rounds, Player A's cumulative wagers reach $2,500, a hidden milestone set by the Milestone Tracking Logic.

Upon meeting this milestone, Player A's ETGT displays an animated message, revealing that they have just triggered a mystery jackpot. The system credits Player A's account with the jackpot winnings, and the milestone is reset for the next player to unknowingly work toward.

At the same time, Player B at a different terminal continues to play without realizing that they are working toward a separate hidden milestone tied to consecutive wins. When Player B achieves three consecutive wins in baccarat, their ETGT reveals the hidden milestone and triggers another jackpot.

### Player Interaction

Players interact with this system through normal gameplay without knowing exactly how or when a jackpot may be triggered. The hidden milestones are not disclosed to players upfront, adding an element of surprise and engagement as they play. This unpredictability enhances the gaming experience by encouraging players to stay active and place consistent wagers, as they never know when they may achieve a hidden milestone and win a jackpot.

Once a player unknowingly reaches a milestone, they are immediately notified via their ETGT that they have triggered a jackpot, adding excitement and reinforcing the sense of reward for their continued play. The hidden nature of the milestones keeps players engaged, as they remain curious about what may trigger the next jackpot.

### Distinguishing Innovative Concepts

The Jackpot Activated by Hidden Milestones system is unique because it introduces undisclosed gameplay objectives that trigger jackpots. This concept deviates from traditional jackpot systems by keeping players in suspense, increasing their emotional engagement and enhancing the element of surprise.

Notable novel features include:
1. Hidden milestone tracking: Players are unaware of the criteria required to trigger a jackpot, which keeps them engaged and playing longer.
2. Surprise jackpot triggers: Jackpots are revealed only when players unknowingly meet the hidden conditions, creating a moment of surprise and excitement.
3. Dynamic milestone adjustments: Casinos may adjust the hidden milestone criteria to suit different games, player demographics, or promotional periods, making the system adaptable and customizable.

### Distinguishing Inventive Steps

1. Milestone monitoring in real time: The system continuously tracks player actions, including bets and game outcomes, against hidden milestone criteria to determine when a jackpot should be triggered.
2. Random or predefined hidden conditions: The system may set specific or randomized milestones for different players, ensuring that the criteria for triggering a jackpot are varied and unpredictable.
3. Immediate jackpot activation: Upon meeting a hidden milestone, the system instantly triggers a jackpot and notifies the player through the ETGT, adding an element of surprise to the gameplay experience.

### 35 USC 101 Considerations

The Jackpot Activated by Hidden Milestones concept offers a practical improvement over conventional jackpot systems by introducing hidden, dynamically tracked objectives that trigger jackpots in a novel way. This system solves the problem of predictable, static jackpot triggers by creating a more engaging and unpredictable experience. The integration of Milestone Tracking Logic with real-time gameplay data and dynamic jackpot triggers enhances the functionality of DETGs, providing a fresh approach that keeps players engaged and motivated to continue playing.

### Data Input

Wager data: The system tracks the size and frequency of each player's bets, using this information to measure progress toward hidden milestones.
Game state data: The system monitors in-game events and outcomes, such as consecutive wins, hand combinations, or other player actions, to determine when a milestone has been met.
Milestone criteria: Predefined or dynamically generated milestones are used to trigger the jackpot when met, based on a variety of player actions and gameplay metrics.

### Component Interactions and Procedural Steps

1. Players engage in normal gameplay on their ETGTs, with each action tracked by the Casino Network Servers.
2. The Milestone Tracking Logic monitors player behavior, such as bet amounts, win streaks, or in-game actions, to determine if they meet any hidden jackpot milestones.
3. When a player unknowingly reaches a milestone, the system triggers a jackpot and sends a notification to the player's ETGT, revealing the hidden achievement and awarding the jackpot.
4. The system resets the milestone conditions for the next jackpot cycle and continues monitoring players' progress.

### Data Processing

The system processes wager data and game state data in real time, comparing player actions against the hidden milestone criteria. When a player's actions meet the conditions for a jackpot, the system processes the milestone achievement and updates the jackpot pool accordingly. The system ensures that hidden milestones are triggered fairly and that players are notified immediately when they win.

### Outputs and Responses

Players receive surprise notifications on their ETGTs when they meet a hidden milestone, triggering a jackpot. The system displays a celebratory animation and credits the player's account with the jackpot winnings. The system also provides feedback to other players, informing them that a jackpot has been won, while keeping the criteria for the next hidden milestone secret.

### Data Storage and Reporting

The system logs all player interactions with the hidden milestone system, including which milestones were met and when jackpots were triggered. This data is stored on the Casino Network Servers for auditing and analysis. The casino may use this data to adjust the hidden milestone criteria or analyze player behavior to optimize future jackpot cycles.

### Error Handling and Security Measures

The system includes error-checking mechanisms to ensure that hidden milestones are accurately tracked and that jackpots are only triggered when the conditions are legitimately met. If there is a discrepancy in tracking player actions or calculating milestone achievements, the system temporarily halts the jackpot triggers and alerts casino operators for further review. Security measures protect the hidden milestone criteria from being tampered with or revealed to unauthorized parties, ensuring the integrity of the system.

### End of Interaction

Once a jackpot is triggered and the winnings are distributed, the system resets the milestone tracking for the next game session. Players are notified of the jackpot reset, and the system continues to monitor gameplay for future hidden milestones. The unpredictable nature of the milestones keeps players engaged, as they remain unaware of the specific conditions required to win, encouraging extended play in the hopes of unlocking the next jackpot.

### Innovative Concept 27: Jackpot Contribution Accelerator for High-Frequency Players

### Identification of Concept

The Jackpot Contribution Accelerator for High-Frequency Players concept is designed to reward players who engage in high-frequency gameplay by accelerating their contributions to the jackpot pool. The system tracks the frequency of player participation, and as players meet certain thresholds (e.g., number of consecutive rounds or frequency of bets), their contributions to the jackpot pool increase at an accelerated rate. This incentivizes players to remain engaged over longer periods, as the more frequently they play, the larger their potential contribution to the jackpot becomes.

This concept adds a layer of strategic gameplay, where players who maintain consistent betting and frequent play may increase their chances of winning larger jackpots more quickly, as their contributions to the pool grow disproportionately compared to occasional players.

### Sequence Diagram Components

ETGTs: Electronic Table Game Terminals that track player bets, frequency of gameplay, and apply the jackpot contribution accelerator based on participation.
Casino Network Servers: Store player frequency data, track jackpot contributions, and manage the accelerated contribution rates.
Player A, Player B, etc.: Players whose frequency of gameplay is tracked and whose contributions to the jackpot pool are dynamically adjusted based on their betting frequency.
Accelerator Logic: Software that calculates when a player has reached a threshold to activate the jackpot contribution accelerator, increasing their contribution to the jackpot pool.
Jackpot Pool Management System: Manages the size of the jackpot pool, incorporating accelerated contributions from high-frequency players.

### Implementation Details

In this system, the Casino Network Servers track each player's frequency of gameplay and wager amounts over a specific period. The system is designed to recognize when players meet predefined frequency thresholds, such as playing a certain number of consecutive rounds or placing a specified number of bets within a given time frame.

Once a player hits one of these thresholds, the Accelerator Logic kicks in, increasing the rate at which their bets contribute to the jackpot pool. For example, after playing 10 consecutive rounds, a player's contributions to the jackpot pool may double, even if their bet sizes remain the same. This contribution multiplier provides players with a higher stake in the jackpot without requiring them to increase their wagers directly.

The ETGTs display real-time updates to players, showing them when they are nearing an accelerator threshold and notifying them when their contribution rate has been increased. This encourages players to stay engaged and bet more frequently, as their potential for winning a larger portion of the jackpot grows as they meet the frequency requirements.

### Example Walk-Through Scenario

Player A has been playing baccarat at an ETGT for several consecutive rounds. As Player A reaches the 10th consecutive round, the Accelerator Logic recognizes that they have met the threshold for the jackpot contribution accelerator to activate.

Player A's ETGT displays a notification that their contributions to the jackpot pool are now being doubled. Although Player A continues placing the same bet amounts, their contributions to the jackpot pool grow at twice the rate. As a result, Player A's potential winnings from the jackpot increase more rapidly compared to other players who are not betting as frequently.

This system encourages Player A to keep playing, knowing that their consistent participation has earned them an advantage in the jackpot race, making it more that they will have a larger share if the jackpot is triggered.

### Player Interaction

Players interact with the Jackpot Contribution Accelerator system through regular gameplay. As players continue to place bets and engage in multiple consecutive rounds, the system tracks their frequency of play and notifies them when they are approaching an accelerator threshold. Once the threshold is reached, players are informed that their contributions to the jackpot pool have been accelerated, and they may see their increased impact on the jackpot size through the ETGT display.

This dynamic encourages players to stay engaged for longer periods, knowing that consistent play will reward them with a greater share of the jackpot. The ability to see real-time updates on their contribution rate adds an element of excitement and motivation to continue betting.

### Distinguishing Innovative Concepts

The Jackpot Contribution Accelerator for High-Frequency Players is distinguished by its focus on rewarding frequent players with accelerated jackpot contributions. Unlike traditional systems where contributions are fixed based on wager size, this concept dynamically increases contributions based on player participation frequency.

Notable novel features include:
1. Frequency-based contribution acceleration: Players who bet frequently or play consecutive rounds receive accelerated contributions to the jackpot pool, incentivizing sustained engagement.
2. Real-time feedback: Players are kept informed of their contribution rate and notified when they reach accelerator thresholds, creating an interactive and motivating gameplay experience.
3. Strategic incentive for frequent play: The system encourages players to maintain consistent gameplay, offering a clear reward in the form of increased jackpot contributions for high-frequency participation.

### Distinguishing Inventive Steps

1. Tracking player frequency: The system continuously monitors each player's frequency of participation, calculating when they meet predefined thresholds for the contribution accelerator to activate.
2. Accelerated contribution multiplier: Once a player reaches a threshold, their contributions to the jackpot pool are increased, allowing them to influence the jackpot size more significantly without having to increase their bet amounts.
3. Dynamic reward for sustained engagement: The system rewards players for consistent participation, offering them a competitive advantage in the jackpot race through increased contribution rates.

### 35 USC 101 Considerations

The Jackpot Contribution Accelerator for High-Frequency Players provides a concrete, non-abstract improvement to the conventional jackpot system by integrating real-time frequency tracking and dynamic contribution adjustments. This innovative concept offers a practical solution to the problem of player engagement by directly rewarding frequent players with increased contributions to the jackpot pool. The technical implementation-real-time tracking of player participation and the dynamic adjustment of contribution rates-enhances the functionality of DETG systems, providing a tangible benefit to both players and casinos by encouraging sustained gameplay.

### Data Input

Player participation data: The system tracks the frequency of player participation, including the number of consecutive rounds played and the number of bets placed within a set time frame.
Wager data: The system monitors the size of each player's bet to calculate their contribution to the jackpot pool.
Threshold data: Predefined frequency thresholds are used to determine when the contribution accelerator should activate for each player.

### Component Interactions and Procedural Steps

1. Players place bets via ETGTs, and the system tracks their frequency of play.
2. As players reach certain participation thresholds (e.g., consecutive rounds or frequent betting), the Casino Network Servers notify the Accelerator Logic to apply an increased contribution rate to the jackpot pool.
3. The ETGTs display real-time updates to players, informing them when their contribution rate has been accelerated.
4. The Jackpot Pool Management System dynamically adjusts the jackpot pool size based on the accelerated contributions from high-frequency players.

### Data Processing

The system processes player participation data and wager data to track the frequency of each player's gameplay. Once a player meets a predefined threshold, the Accelerator Logic increases their contribution rate to the jackpot pool, updating the pool size in real time. The system ensures that players who play more frequently are rewarded with higher contributions, making their potential share of the jackpot more significant.

### Outputs and Responses

Players receive real-time notifications on their ETGTs when they reach an accelerator threshold, informing them that their contribution rate to the jackpot pool has been increased. The system continuously updates the jackpot pool size, reflecting the accelerated contributions from high-frequency players and providing immediate feedback on the growing jackpot.

### Data Storage and Reporting

The system logs all player interactions with the accelerator system, including their frequency of play, contribution rates, and the impact on the jackpot pool. This data is stored on the Casino Network Servers and may be used for reporting and analysis, allowing the casino to evaluate player engagement and the effectiveness of the contribution accelerator.

### Error Handling and Security Measures

The system includes error-checking mechanisms to ensure that players' contributions are accurately tracked and that the accelerator is applied only when the frequency thresholds are met. If a discrepancy occurs in tracking player participation or applying the accelerator, the system flags the issue for review and temporarily halts the contribution acceleration until the error is resolved. Security protocols prevent unauthorized access to the accelerator logic, ensuring that the system remains fair and transparent.

### End of Interaction

Once the jackpot is triggered and distributed, the system resets the contribution accelerator for all players, preparing for the next round of gameplay. Players are notified that the jackpot has been won, and the system resumes tracking their participation for the next jackpot cycle. The accelerator system ensures that frequent players remain engaged and incentivized to continue betting, knowing that their consistent participation will reward them with greater influence over the jackpot pool.

### Innovative Concept 28: Player-Specific Jackpot Unlocks Based on VIP Level

### Identification of Concept

The Player-Specific Jackpot Unlocks Based on VIP Level concept introduces a dynamic jackpot system where players are granted access to exclusive jackpots based on their VIP status or loyalty tier within the casino. As players accumulate VIP points through consistent play, high wager amounts, or long-term participation, they unlock access to higher-value, exclusive jackpots that are not available to regular players. This system incentivizes loyalty and rewards VIP players by offering them larger, more frequent, or unique jackpots based on their tier.

This concept allows casinos to personalize the jackpot experience for high-value players, creating a tailored reward system that encourages ongoing engagement and rewards long-term commitment.

### Sequence Diagram Components

ETGTs: Player terminals where bets are placed, and players are informed about their access to exclusive VIP jackpots based on their loyalty status.
Casino Network Servers: Track player VIP levels, manage their access to different tiers of jackpots, and control the contribution and distribution of VIP-specific jackpot pools.
Player A, Player B, etc.: Players participating in the game who unlock exclusive jackpots based on their VIP level.
VIP Level Tracking Logic: Software that monitors player status and grants access to specific jackpot tiers based on loyalty or VIP points.
Jackpot Pool Management System: Manages different jackpot pools, with specific pools reserved for players in higher VIP tiers.

### Implementation Details

In this system, each player's VIP level is tracked through the VIP Level Tracking Logic, which monitors their loyalty status based on factors such as total wagers, time spent playing, and participation in casino promotions. As players accumulate VIP points or meet predefined criteria, they unlock access to exclusive jackpot pools.

The ETGTs display real-time updates to players, informing them when they have unlocked access to a higher-tier jackpot pool based on their VIP level. The higher the player's VIP status, the more valuable and frequent the jackpots become. For example, a player at a Bronze VIP level may only have access to a standard jackpot pool, while a Platinum-level player may unlock larger, more exclusive jackpots that only a small number of high-status players may compete for.

The Casino Network Servers manage the contributions to these VIP-specific jackpot pools, ensuring that only players who meet the loyalty criteria may contribute to or win from these exclusive jackpots. The Jackpot Pool Management System dynamically adjusts the size of the VIP jackpot pools based on contributions from eligible players, ensuring that the pool grows in proportion to the participation of high-level VIP players.

### Example Walk-Through Scenario

Player A, a Silver-level VIP, and Player B, a Platinum-level VIP, are both playing baccarat on their respective ETGTs. As Player B has a higher VIP status, their terminal informs them that they have access to an exclusive Platinum-tier jackpot, which offers a significantly higher payout than the regular jackpot pool.

Player A continues to participate in the standard jackpot pool, while Player B contributes to the Platinum jackpot pool, knowing that fewer players are competing for this exclusive prize. As Player B continues to play and wager at high levels, their contributions increase the size of the Platinum-tier jackpot, while Player A's bets contribute to the regular jackpot.

When Player B triggers the Platinum-tier jackpot by meeting the win conditions, they are awarded the exclusive prize, while Player A remains eligible for the standard jackpot.

### Player Interaction

Players interact with this system through their ETGTs, which display real-time updates on their VIP level and the corresponding jackpots they are eligible for. As players accumulate VIP points or increase their loyalty status, they unlock access to higher-tier jackpot pools. Players are motivated to maintain their VIP status or move up to higher tiers by continuing to play and wager at increased levels.

This system also creates a sense of exclusivity, as high-VIP players know that they have access to unique jackpots that are not available to the general player base. The dynamic nature of the jackpots—where players see their potential rewards increase as they progress through the VIP tiers-keeps players engaged and loyal to the casino.

### Distinguishing Innovative Concepts

The Player-Specific Jackpot Unlocks Based on VIP Level concept is novel because it introduces a VIP-tiered jackpot system that personalizes the jackpot experience based on a player's loyalty or VIP status. This dynamic rewards system encourages long-term engagement and higher stakes, as players aim to unlock more valuable jackpots.

Notable novel features include:
1. VIP-tiered jackpots: Players unlock access to exclusive jackpots based on their VIP level, creating a tiered system where high-value players are rewarded with larger and more frequent jackpots.
2. Personalized reward structure: Each player's jackpot experience is tailored to their loyalty status, offering incentives for players to increase their VIP level and gain access to more valuable prizes.
3. Dynamic jackpot contribution based on VIP status: The system adjusts the size and frequency of jackpots based on player participation and VIP level, ensuring that high-level players compete for proportionally larger prizes.

### Distinguishing Inventive Steps

1. Tracking and updating VIP status: The system continuously tracks each player's VIP level and adjusts their access to exclusive jackpot pools based on their loyalty status.
2. Dynamic jackpot assignment: As players unlock higher VIP tiers, they are automatically assigned to more valuable jackpot pools, where they compete only with players of similar status.
3. Proportional jackpot contributions: The system dynamically adjusts the contributions and size of the jackpot pool based on the participation of VIP players, ensuring that high-status players have access to proportionally larger jackpots.

### 35 USC 101 Considerations

The Player-Specific Jackpot Unlocks Based on VIP Level concept provides a specific technical improvement by integrating player tracking and loyalty systems with jackpot management. This innovative concept enhances the functionality of DETGs by creating a dynamic and personalized jackpot system that rewards loyalty and incentivizes long-term engagement. The system solves the problem of static, one-size-fits-all jackpots by offering players rewards based on their individual VIP status, which is a practical application of loyalty program data integrated with jackpot mechanics.

### Data Input

VIP level data: The system tracks each player's VIP status based on their accumulated points, wager amounts, and loyalty activity, using this data to unlock access to specific jackpot pools.
Wager data: The system monitors the size and frequency of each player's bets, which contribute to the jackpot pools in proportion to the player's VIP level.
Jackpot pool data: Each VIP-tiered jackpot pool is dynamically updated based on contributions from eligible players, with separate pools for different VIP tiers.

### Component Interactions and Procedural Steps

1. Players place wagers via ETGTs, and their VIP Level Tracking Logic updates their loyalty status in real time.
2. As players reach certain VIP levels, they unlock access to exclusive jackpot pools, and the Casino Network Servers dynamically assign their contributions to the appropriate pool.
3. The Jackpot Pool Management System tracks the contributions from players in each VIP tier, adjusting the jackpot size accordingly and ensuring that each player competes for jackpots within their tier.
4. When a VIP player triggers a jackpot, the system distributes the winnings based on the size of the VIP-specific jackpot pool, and the ETGT notifies the player of their win.

### Data Processing

The system processes VIP level data and wager data in real time, updating each player's access to VIP-tiered jackpot pools as they progress through loyalty levels. The system calculates the contributions from eligible players and adjusts the size of each jackpot pool based on the participation of VIP players. When a jackpot is triggered, the system calculates the payout based on the player's VIP tier and the size of the corresponding jackpot pool.

### Outputs and Responses

Players receive real-time updates on their ETGTs, informing them of their current VIP status and which jackpots they are eligible to participate in. When a player reaches a new VIP tier, the system notifies them of their access to exclusive jackpots, encouraging them to continue playing to unlock even higher-tier rewards. Once a jackpot is triggered, the system distributes the winnings to the eligible VIP player(s) and resets the pool for the next cycle.

### Data Storage and Reporting

This data is stored on the Casino Network Servers and may be used for auditing, reporting, and performance analysis. Casinos may analyze VIP player behavior, contributions to different jackpot pools, and the overall effectiveness of the VIP-tiered system. This information helps casinos optimize their loyalty programs, adjust jackpot tiers, and track the impact of VIP rewards on player engagement and retention.

### Error Handling and Security Measures

The system includes error-checking mechanisms to ensure that players are accurately assigned to the correct VIP-tiered jackpot pool based on their loyalty status. If a discrepancy occurs in tracking VIP points or assigning contributions to the appropriate jackpot, the system flags the issue for review and temporarily halts contributions until the error is resolved. Security protocols ensure that only authorized personnel may modify VIP thresholds or access player-specific jackpot data, protecting the integrity of the system and preventing unauthorized access to high-value VIP jackpots.

### End of Interaction

Once a jackpot is triggered, the system resets the VIP-specific jackpot pool and notifies all eligible players of the reset. Players are informed of the next opportunity to contribute to their respective tiered jackpots based on their VIP level. The system continues to track player engagement and VIP status in real time, ensuring that high-value players remain motivated to participate and contribute to exclusive jackpots. The cycle of unlocking, contributing to, and triggering VIP jackpots creates ongoing engagement, encouraging loyalty and high-frequency play from premium players.

### Innovative Concept 29: Jackpot Multiplier for Consecutive Game Wins

### Identification of Concept

The Jackpot Multiplier for Consecutive Game Wins concept introduces a dynamic jackpot system where the size of the jackpot payout is multiplied based on a player's streak of consecutive game wins. The longer a player's win streak, the higher the multiplier applied to the jackpot payout, encouraging players to focus on skillful gameplay and strategy to maximize their potential winnings. The multiplier incentivizes sustained and consistent winning, adding an extra layer of excitement and strategy to the game.

The multiplier is applied at the point when a jackpot is triggered, and the size of the multiplier is determined by the number of consecutive wins the player has achieved. This creates a direct correlation between player performance and jackpot rewards.

### Sequence Diagram Components

ETGTs: Terminals where players place wagers and participate in games, tracking consecutive wins and applying jackpot multipliers based on streak length.
Casino Network Servers: Monitor player win streaks and manage the application of multipliers to jackpot payouts when a streaking player wins the jackpot.
Player A, Player B, etc.: Players whose win streaks are tracked in real time, and whose jackpot payouts are multiplied based on the number of consecutive game wins.
Win Streak Tracking Logic: Software that monitors player win streaks and calculates the multiplier to be applied to the jackpot payout based on the streak length.
Multiplier Application System: Dynamically adjusts the jackpot payout size based on the player's win streak when the jackpot is triggered.

### Implementation Details

In this system, the Win Streak Tracking Logic monitors each player's consecutive wins across multiple rounds of gameplay. Each time a player wins a game, their streak is recorded, and the system calculates a corresponding multiplier that will be applied to the jackpot if the player triggers it while on a winning streak.

For example:
A player with a streak of 3 consecutive wins may receive a 1.5× multiplier on the jackpot.
A player with 5 consecutive wins may see their jackpot payout multiplied by 2×.
A player with 10 or more consecutive wins may receive an even higher multiplier, such as 3× or 5×.

The ETGTs notify players of their current win streak and display the potential multiplier that may be applied if they win the jackpot while maintaining the streak. This creates an additional incentive for players to stay focused on their gameplay, as the potential jackpot payout grows in direct relation to their win streak.

When a player on a winning streak triggers the jackpot, the Multiplier Application System adjusts the size of the payout according to the multiplier associated with their win streak. If the player's streak is broken before the jackpot is triggered, the multiplier resets, and the player returns to a standard payout structure.

### Example Walk-Through Scenario

Player A starts playing baccarat at a DETG and wins the first three rounds in a row. The Win Streak Tracking Logic records Player A's streak and displays a message on their ETGT indicating that their jackpot payout will be multiplied by 1.5× if they trigger the jackpot while maintaining the streak.

As Player A continues to win consecutive rounds, their streak grows to five wins, and the system updates the ETGT to inform Player A that their jackpot payout will now be multiplied by 2×. Player A is encouraged to continue playing, as their potential jackpot reward increases with each additional win.

When Player A finally triggers the jackpot after seven consecutive wins, the system applies a 2.5× multiplier to the jackpot payout, resulting in a significantly larger prize than the base jackpot amount. The win streak is then reset, and Player A begins a new streak in subsequent rounds.

### Player Interaction

Players interact with the Jackpot Multiplier for Consecutive Game Wins system through normal gameplay. The system tracks their win streaks and provides real-time updates on their current streak and the multiplier that will be applied to the jackpot payout if they win. This interaction motivates players to focus on improving their game performance, as maintaining a winning streak directly increases their potential jackpot payout.

The real-time feedback provided by the ETGTs adds an extra layer of excitement, as players may see the growing value of the jackpot multiplier with each consecutive win. This dynamic encourages extended play sessions, as players seek to maximize their win streak and corresponding jackpot rewards.

### Distinguishing Innovative Concepts

The Jackpot Multiplier for Consecutive Game Wins concept is novel because it introduces a performance-based multiplier to jackpot payouts, directly linking the size of the payout to the player's in-game performance. This concept rewards skillful gameplay and consistency, making the jackpot experience more engaging and personalized.

Notable novel features include:
1. Win streak-based multiplier: The system dynamically increases the jackpot payout based on the number of consecutive wins a player achieves, adding a performance-driven reward element.
2. Real-time feedback: Players are informed of their current streak and potential multiplier through the ETGTs, creating a motivating and strategic gameplay experience.
3. Incentive for sustained wins: The system encourages players to focus on maintaining win streaks, adding a strategic layer to gameplay and increasing engagement.

### Distinguishing Inventive Steps

1. Win streak tracking: The system continuously monitors each player's win streak and calculates the corresponding multiplier based on the length of the streak.
2. Dynamic multiplier application: When a player triggers a jackpot, the system applies the multiplier based on their win streak, adjusting the payout in real time.
3. Reset upon streak loss: If a player loses a round before triggering the jackpot, their win streak and associated multiplier are reset, returning the payout to the

### Sequence Diagram Components

ETGTs: Electronic Table Game Terminals where players place wagers and participate in games, tracking consecutive wins and applying jackpot multipliers based on the length of the winning streak.
Casino Network Servers: Track the number of consecutive wins for each player, manage the multiplier logic, and calculate the jackpot payouts based on the player's streak.
Player A, Player B, etc.: Players engaging in gameplay whose win streaks are monitored and used to apply a multiplier to potential jackpot payouts.
Win Streak Tracking Logic: Software that monitors player game results, calculating consecutive wins and determining the multiplier value for the jackpot.
Jackpot Payout Management System: Dynamically adjusts jackpot payouts by applying the multiplier based on the player's winning streak when a jackpot is triggered.

### Implementation Details

In this system, the Win Streak Tracking Logic monitors each player's consecutive game wins, storing the streak information on the Casino Network Servers. As players continue to win rounds in their respective games, the system increments the win streak counter for that player. The more consecutive wins a player achieves, the higher the multiplier that will be applied to their jackpot payout when the jackpot is triggered.

For example, a player with a win streak of three consecutive wins may have a 2× multiplier applied to their jackpot, while a player with five consecutive wins may have a 3× multiplier applied. This multiplier only activates if the player triggers the jackpot during their streak, incentivizing players to focus on achieving longer win streaks for larger potential payouts.

The ETGTs display real-time feedback, showing players their current win streak and the multiplier they have earned. If a player loses a game, their streak is reset, and they must start building a new streak to earn future multipliers.

### Example Walk-Through Scenario

Player A begins playing roulette on an ETGT and wins three consecutive rounds. As their win streak increases, the ETGT informs them that they have earned a 2× multiplier for any jackpot they may trigger while on their current streak.

Player A continues to play, and after achieving five consecutive wins, their multiplier increases to 3×. During the next round, Player A triggers the jackpot. Because of their winning streak, the Jackpot Payout Management System applies the 3× multiplier, and Player A's jackpot payout is tripled, resulting in a significantly larger prize.

Player B, who has been playing blackjack, wins two rounds consecutively and is informed that they have earned a 1.5× multiplier. However, Player B loses the next round, resetting their win streak and returning their multiplier to its default state.

### Player Interaction

Players interact with the Jackpot Multiplier for Consecutive Game Wins system through their regular gameplay. As they win consecutive rounds, the system tracks their streak and displays their current multiplier on the ETGT. This interaction adds a layer of excitement and strategy, as players are motivated to win consecutive rounds to increase their multiplier and maximize their potential jackpot payout.

The ETGTs provide players with real-time updates on their current streak and multiplier, fostering engagement and encouraging players to maintain their streaks. If a player's streak is broken, the system resets their multiplier, and they must work to rebuild it through additional consecutive wins.

### Distinguishing Innovative Concepts

The Jackpot Multiplier for Consecutive Game Wins system introduces a unique feature that ties the jackpot payout to player performance, specifically rewarding consecutive wins with enhanced payouts. This innovative concept encourages skillful and strategic gameplay, rewarding players who may sustain winning streaks.

Notable novel features include:
1. Win-streak-based multipliers: The jackpot payout is multiplied based on the length of a player's consecutive win streak, offering an additional layer of engagement and reward.
2. Real-time streak tracking: Players receive immediate feedback on their win streak and the corresponding multiplier, keeping them motivated to continue playing and winning.
3. Dynamic jackpot adjustments: The system dynamically adjusts the jackpot payout based on each player's performance, offering larger payouts to players who achieve sustained winning streaks.

### Distinguishing Inventive Steps

1. Tracking and monitoring win streaks: The system continuously monitors each player's game results, tracking their consecutive wins and adjusting the multiplier accordingly.
2. Multiplier-based jackpot calculation: When a player triggers the jackpot, the system calculates the payout by applying the multiplier earned through their win streak, enhancing the player's overall prize.
3. Reset and rebuild mechanics: If a player loses a round, their win streak and multiplier are reset, requiring them to start building a new streak for future jackpot multipliers.

### 35 USC 101 Considerations

The Jackpot Multiplier for Consecutive Game Wins concept provides a specific technical solution to enhancing player engagement by tying jackpot payouts to player performance. This system solves the problem of static jackpot rewards by introducing a dynamic multiplier that grows with the player's win streak, creating a more interactive and skill-based jackpot experience. The use of real-time win streak tracking, dynamic multiplier adjustments, and personalized payout calculations integrates into a practical application, improving the overall functionality of DETG systems and enhancing player motivation.

### Data Input

Game result data: The system tracks each player's game outcomes (win/loss) to determine their current win streak.
Wager data: The system monitors the size of each player's bet, which contributes to the jackpot pool.
Win streak thresholds: Predefined thresholds determine the multiplier value based on the length of a player's consecutive win streak.

### Component Interactions and Procedural Steps

1. Players place wagers via their ETGTs, and the system tracks their game results.
2. The Win Streak Tracking Logic calculates the length of each player's win streak and adjusts the multiplier accordingly, based on predefined thresholds.
3. The ETGTs display real-time updates to players, informing them of their current streak and the associated multiplier.
4. When a player triggers the jackpot, the Jackpot Payout Management System applies the multiplier earned from their win streak to calculate the final payout.

### Data Processing

The system processes game result data to track each player's win streak and dynamically adjust the multiplier associated with their potential jackpot payout. When a jackpot is triggered, the system applies the appropriate multiplier based on the player's current streak and calculates the final payout amount. The system also tracks when a player's streak is reset due to a loss, ensuring that the multiplier is removed until a new streak is built.

### Outputs and Responses

Players receive real-time notifications on their ETGTs showing their current win streak, the corresponding multiplier, and the potential enhanced jackpot payout. If a jackpot is triggered during a win streak, the system informs the player of their multiplied payout and displays celebratory graphics, increasing engagement and excitement.

### Data Storage and Reporting

The system logs all player win streaks, jackpot triggers, and multiplier applications for auditing and reporting purposes. This data is stored on the Casino Network Servers and may be analyzed to track player performance, optimize multiplier thresholds, and evaluate the impact of the win streak feature on player engagement and retention.

### Error Handling and Security Measures

The system includes error-checking mechanisms to ensure that win streaks are accurately tracked and that multipliers are correctly applied to jackpot payouts. If a discrepancy occurs in tracking a player's streak or calculating their multiplier, the system temporarily halts the multiplier feature and flags the issue for review. Security protocols ensure that the streak tracking and multiplier logic are protected from tampering, preventing unauthorized adjustments to player win streaks or jackpot payouts.

### End of Interaction

Once a jackpot is triggered and the multiplier is applied, the system resets the player's win streak and prepares for the next gameplay session. Players are notified that their streak has been reset and that they may begin building a new streak to earn future multipliers. The system continues tracking win streaks for all active players, ensuring that consecutive wins are rewarded with enhanced jackpot payouts, encouraging longer play sessions and more strategic gameplay.

### Innovative Concept 30—Mystery Jackpot Insurance Feature

Identification of Concept: The Mystery Jackpot Insurance Feature is an innovative concept designed for live dealer-controlled multiplayer games implemented at live dealer-streamed electronic game table systems and Dealer-controlled Electronic Table Games systems (DETGs). This feature allows players to purchase “insurance” that increases their share of the jackpot if another player wins. The concept adds a new layer of engagement and strategy to the traditional mystery jackpot format, allowing players to hedge their bets and potentially benefit even when they are not the primary jackpot winner. This feature is particularly well-suited for implementation in DETGs, as it leverages the electronic interface to seamlessly integrate the insurance option into the gameplay, track player participation, and calculate payouts in real-time.

### Sequence Diagram Components:

1. Electronic Table Game Terminal (ETGT): The primary interface for players, displaying game information, jackpot status, and insurance options.
2. Player A: A participant in the live dealer game who may choose to purchase jackpot insurance.
3. Player B: Another participant who may win the mystery jackpot.
4. Dealer Interface: The system used by the live dealer to manage the game and trigger jackpot-related events.
5. Jackpot Management System (JMS): A backend component that tracks jackpot accumulation, insurance purchases, and calculates payouts.
6. Player Tracking System: Interfaces with the ETGT to track player activity and manage loyalty points.
7. Casino Management System (CMS): Oversees all gaming activities and integrates with the JMS and Player Tracking System.
8. Random Number Generator (RNG): Determines the triggering of the mystery jackpot.
9. Insurance Pool Manager: A subsystem of the JMS that manages the pool of funds from insurance purchases.

Implementation Details: The Electronic Table Game Terminal (ETGT) is configured with a dedicated interface for the Mystery Jackpot Insurance Feature. This interface includes a clear display of the current jackpot amount, the cost of insurance, and the potential payout percentage for insured players. The ETGT's software is updated to include an insurance purchase option, which is seamlessly integrated into the existing betting interface. When a player opts to purchase insurance, the ETGT communicates this information to the Jackpot Management System (JMS) via a secure network protocol.

The JMS is enhanced to maintain separate pools for the main jackpot and the insurance fund. It uses sophisticated algorithms to dynamically calculate insurance costs and potential payouts based on the number of insured players and the current jackpot size. This ensures that the feature remains profitable for the casino while offering attractive potential returns to players.

The Dealer Interface is equipped with a specialized module that allows the dealer to monitor insurance purchases and jackpot status in real-time. This information is notable for maintaining game integrity and enhancing the live dealer's ability to engage with players about the jackpot feature.

A notable implementation detail is the integration of a high-performance Random Number Generator (RNG) that determines when the mystery jackpot is triggered. This RNG is designed to operate independently of the main game outcomes, ensuring fairness and unpredictability in jackpot awards.

The Player Tracking System is modified to record insurance purchases as a distinct type of wager, allowing for detailed analysis of player behavior and preferences related to this feature. This data is valuable for refining the feature and for targeted marketing efforts.

Example Walk-through Scenario: Player A sits down at an ETGT and logs in using their player card. The ETGT displays the current mystery jackpot amount of $10,000 and offers jackpot insurance for $5. Player A decides to purchase insurance and taps the “Buy Insurance” button on the touchscreen. The ETGT confirms the purchase and deducts $5 from Player A's balance, sending this information to the JMS.

As the game progresses, other players join, some purchasing insurance and others declining. The dealer initiates each round of the game through their interface, which also displays the growing jackpot amount and the number of insured players.

Suddenly, the RNG triggers the mystery jackpot, and Player B, who did not purchase insurance, wins the full $10,000. The JMS immediately calculates the insurance payout. In this scenario, let's say the insurance pool has accumulated $100, and the payout percentage for insured players is set at 10% of the jackpot.

The ETGT displays a celebratory animation announcing Player B's win. Simultaneously, it notifies Player A that they will receive an insurance payout of $100 (10% of $10,000, divided among the insured players). The CMS processes the payouts, crediting Player B's account with $10,000 and Player A's account with $100.

The dealer congratulates the winners through the live stream, and the JMS resets the jackpot to its starting value. The ETGTs update to show the new jackpot amount and offer insurance for the next round.

Player Interaction: Players interact with the Mystery Jackpot Insurance Feature primarily through their individual ETGTs. When a player first joins the game, they are presented with clear information about the current jackpot amount and the option to purchase insurance. This information is displayed on a dedicated area of the ETGT screen, separate from the main game interface to avoid confusion.

To purchase insurance, a player simply taps the “Buy Insurance” button and confirms their choice. The ETGT provides immediate feedback, showing the insurance purchase as active and updating the player's balance. Throughout the game, insured players see a special indicator on their screen, reminding them of their protected status.

Players may view detailed information about the insurance feature at any time by accessing a help menu on the ETGT. This includes explanations of how the insurance works, potential payout calculations, and historical data on insurance payouts.

When a jackpot is won, all ETGTs display an exciting animation. Insured players receive personalized messages informing them of their insurance payout, if any. This creates a sense of participation and excitement even for players who didn't win the main jackpot.

The live dealer also plays a role in player interaction, announcing jackpot wins and insurance payouts verbally, adding to the immersive experience of the live game. Players may interact with the dealer and each other through a chat function on the ETGT, discussing the jackpot and sharing in the excitement of wins and near-misses.

Distinguishing Innovative Concepts: The Mystery Jackpot Insurance Feature introduces several novel concepts that set it apart from traditional jackpot systems in live dealer electronic game table systems and DETGs:
1. Risk Mitigation for Players: Unlike conventional jackpots where only the winner benefits, this system allows multiple players to profit from a single jackpot event. This risk mitigation aspect is unique in the realm of live dealer games and encourages broader participation in the jackpot feature.
2. Dynamic Insurance Pricing: The system employs advanced algorithms to adjust insurance costs in real-time based on the current jackpot size, number of participants, and other factors. This dynamic pricing ensures the feature remains attractive to players while maintaining profitability for the casino.
3. Dual Pool Management: The JMS manages two interrelated but separate pools—the main jackpot and the insurance pool. This dual management system is a novel approach in DETG systems, requiring sophisticated backend processing to ensure accurate and fair distribution of funds.
4. Enhanced Live Dealer Integration: The feature integrates seamlessly with the live dealer format, allowing dealers to interact with players about their insurance status and create excitement around both jackpot and insurance wins. This integration enhances the social aspect of DETGs, bridging the gap between electronic and traditional table games.
5. Personalized Jackpot Experience: By allowing players to choose whether to participate in the insurance feature, the system creates a more personalized jackpot experience. This level of customization is uncommon in traditional jackpot systems and adds a strategic element to jackpot participation.

### Distinguishing Inventive Steps:

1. Real-time Insurance Eligibility Tracking: The system continuously tracks which players have purchased insurance and maintains this information across multiple rounds of play. This persistent tracking across game rounds is a novel feature for DETGs.
2. Adaptive Payout Calculation: When a jackpot is won, the system instantaneously calculates personalized insurance payouts for each eligible player based on the current insurance pool and the number of insured players. This adaptive calculation ensures fair distribution of the insurance pool.
3. Integrated Cross-Table Insurance Pool: In multi-table setups, the system maintains a single insurance pool across all connected tables. This allows for larger insurance pools and more attractive payouts, while also creating a sense of community among players at different tables.

35 USC 101 Considerations: The Mystery Jackpot Insurance Feature represents patentable subject matter under 35 USC 101 for several compelling reasons:

First, this innovative concept goes beyond a mere abstract idea by capturing a specific improvement over prior art in the field of electronic gaming systems. It introduces a novel mechanism for risk management in jackpot participation, which is a concrete and tangible improvement to the functionality of DETGs.

Second, the implementation of this feature is directed at solving a specific problem in the technological process of operating live dealer electronic game tables. It addresses the issue of limited player engagement with traditional jackpot systems by introducing a new layer of strategic decision-making and risk management. This solution is inextricably tied to computer technology, as it may require real-time processing of complex data across networked gaming devices.

Third, the invention integrates the jackpot insurance feature into a practical application that enables a discernible advancement in computer functionality. The system's ability to manage dual pools (jackpot and insurance), calculate dynamic insurance pricing, and process real-time payouts across multiple networked devices represents a significant improvement in the capabilities of electronic gaming systems. Furthermore, the implementation of this feature may require a specific arrangement of electronic components and software algorithms that go beyond generic computer functions. The coordination between ETGTs, the JMS, and other casino systems to offer, track, and settle insurance purchases in real-time during live gameplay demonstrates a non-conventional and non-generic arrangement of computer components.

Data Input: The Mystery Jackpot Insurance Feature may require several types of data inputs from players and other systems:
1. Player Insurance Purchase: Players input their decision to buy insurance through the ETGT interface. This input is a simple yes/no choice but may be processed immediately to ensure eligibility for the current game round.
2. Player Identification: The system may require input of player identification, typically through a player card or login process, to track insurance purchases and eligibility across multiple rounds or sessions.
3. Jackpot Trigger: The RNG provides input to determine when the mystery jackpot is triggered. This input is notable and may be verifiably random to ensure game integrity.
4. Dealer Inputs: The live dealer provides inputs through their interface to start game rounds, which synchronizes the timing of insurance eligibility with the main game.
5. Casino Management Inputs: The CMS provides inputs such as table limits, insurance pricing parameters, and payout percentages, which the system uses to calculate insurance costs and potential payouts.

This data input process is unique for DETGs as it combines electronic inputs from players with live dealer actions and backend system parameters, creating a seamless integration between the physical and digital aspects of the game.

### Component Interactions and Procedural Steps:

1. Insurance Purchase: When a player chooses to purchase insurance, the ETGT sends this information to the JMS. The JMS updates the insurance pool, logs the purchase against the player's ID, and sends confirmation back to the ETGT.
2. Jackpot Accumulation: As players make bets on the main game, the JMS increments the jackpot amount based on a predetermined percentage. This updated jackpot amount is broadcast to all connected ETGTs and the dealer interface.
3. Insurance Eligibility Tracking: Before each game round, the JMS communicates with all ETGTs to confirm which players have active insurance. This information is stored in a rapidly accessible format to enable quick payout calculations.
4. Mystery Jackpot Trigger: When the RNG signals a jackpot win, it communicates this to the JMS. The JMS then initiates a series of processes: a. It identifies the winning player and notifies their ETGT. b. It calculates the insurance payouts for all eligible players. c. It sends payout information to each ETGT and the CMS for processing.
5. Payout Processing: The CMS receives payout instructions from the JMS and processes them, updating player balances across all relevant systems.
6. Dealer Notification: The dealer interface is updated with information about the jackpot win and insurance payouts, allowing the dealer to announce this information to players.
7. Reset Process: After payouts are confirmed, the JMS resets the jackpot to its starting value and clears the insurance pool. This reset is communicated to all ETGTs and the dealer interface.

Data Processing: The system processes data through several notable steps:
1. Insurance Cost Calculation: The JMS continuously recalculates the cost of insurance based on the current jackpot size, number of insured players, and predetermined profitability parameters.
2. Eligibility Verification: When the jackpot is triggered, the system rapidly verifies the insurance status of all active players.
3. Payout Calculation: The system calculates individual insurance payouts based on the total insurance pool and the number of eligible players.
4. Historical Data Analysis: The system processes historical data on insurance purchases and payouts to refine pricing models and inform casino management decisions.

Outputs and Responses: The system provides various outputs to players, dealers, and casino management:
1. Player Notifications: ETGTs display insurance purchase confirmations, jackpot win animations, and personalized payout messages.
2. Dealer Interface Updates: The dealer's screen shows real-time information on the jackpot size, number of insured players, and recent wins.
3. Casino Management Reports: The CMS generates reports on insurance feature performance, player engagement rates, and profitability metrics.
4. Public Displays: Large screens in the casino area may show jackpot amounts and recent insurance payouts to encourage participation.

Data Storage and Reporting: The system stores various types of data:
1. Individual Insurance Purchases: Linked to player IDs and stored for the duration of eligibility.
2. Jackpot and Insurance Pool Amounts: Continuously updated and stored for auditing purposes.
3. Win Events: Detailed records of jackpot triggers and insurance payouts.
4. Aggregate Performance Data: Long-term storage of feature performance metrics for trend analysis.

This data is reported through regular automated reports to casino management and is available for real-time querying through the CMS.

Error Handling and Security Measures: The system incorporates robust error handling and security measures:
1. Transaction Verification: All insurance purchases and payouts are verified through multiple system checks.
2. Data Encryption: All communications between system components are encrypted to prevent tampering.
3. Redundancy: Notable components like the JMS have redundant backups to ensure continuous operation.
4. Audit Trails: The system maintains detailed logs of all transactions for regulatory compliance and dispute resolution.

End of Interaction: At the end of each gaming session or when a player leaves the table, the system:
1. Settles any outstanding insurance transactions.
2. Updates the player's history in the Player Tracking System.
3. Resets the ETGT for the next player, clearing any personalized insurance information.
4. Sends a session summary to the CMS for record-keeping and analysis.

This comprehensive end-of-interaction process ensures a clean transition between players and maintains the integrity of the Mystery Jackpot Insurance Feature across multiple gaming sessions.

### Innovative Concept 31—Mystery Jackpot Linked to Dealer Wins

Identification of Concept: The Mystery Jackpot Linked to Dealer Wins is an innovative concept designed for live dealer-controlled multiplayer games implemented at live dealer-streamed electronic game table systems and Dealer-controlled Electronic Table Games systems (DETGs). This feature introduces a new dimension to the traditional mystery jackpot by linking the jackpot trigger to specific dealer outcomes, such as consecutive wins. This concept enhances player engagement by creating a shared experience where all players at the table may potentially benefit from the dealer's performance. It leverages the unique aspects of live dealer games, bridging the gap between electronic gaming and the excitement of traditional table games. The system is particularly well-suited for DETGs as it utilizes real-time data processing and display capabilities to track dealer performance and communicate jackpot status to players across multiple networked tables.

### Sequence Diagram Components:

1. Electronic Table Game Terminal (ETGT): The primary interface for players, displaying game information, dealer performance metrics, and jackpot status.
2. Player A: A participant in the live dealer game who may win the mystery jackpot.
3. Player B: Another participant in the game.
4. Dealer Interface: The system used by the live dealer to manage the game and input game outcomes.
5. Dealer Performance Tracker (DPT): A specialized component that monitors and records dealer game outcomes.
6. Jackpot Management System (JMS): Manages jackpot accumulation, triggering conditions, and payouts.
7. Casino Management System (CMS): Oversees all gaming activities and integrates with the JMS and Player Tracking System.
8. Player Tracking System: Interfaces with the ETGT to track player activity and manage loyalty points.
9. Random Number Generator (RNG): Used in conjunction with dealer outcomes to determine jackpot triggers.
10. Jackpot Display System: Large screens or integrated displays showing jackpot amounts and dealer performance across multiple tables.

Implementation Details: The Electronic Table Game Terminal (ETGT) is enhanced with a dedicated interface section for displaying dealer performance metrics relevant to the mystery jackpot. This includes a visual representation of the dealer's current win streak, historical performance, and the progress towards triggering the jackpot. The ETGT software is updated to include real-time notifications about the jackpot status and potential upcoming triggers based on dealer performance.

The Dealer Interface is equipped with an advanced input system that allows for rapid and accurate recording of game outcomes. This system is directly linked to the Dealer Performance Tracker (DPT), which analyzes the data in real-time. The DPT uses sophisticated algorithms to identify patterns in dealer outcomes that may lead to jackpot triggers.

A notable implementation detail is the integration of the Jackpot Management System (JMS) with the DPT. The JMS uses data from the DPT to determine when jackpot conditions are met. It also incorporates a Random Number Generator (RNG) to add an element of unpredictability to the jackpot triggers, ensuring that while dealer performance influences the jackpot, it doesn't make it entirely predictable.

The Casino Management System (CMS) is updated to handle the unique aspects of this jackpot system, including managing jackpot pools across multiple tables and adjusting game parameters to maintain optimal house edge and player excitement levels.

A novel feature of this implementation is the Jackpot Display System, which shows dealer performance and jackpot information across multiple tables. This creates a sense of community and excitement across the casino floor, encouraging players to engage with the jackpot feature.

Example Walk-through Scenario: Player A sits down at an ETGT and logs in. The screen displays the current mystery jackpot amount of $5,000 and shows that the dealer has won 3 consecutive hands. The ETGT interface indicates that 5 consecutive dealer wins will trigger a jackpot opportunity.

As the game progresses, the dealer wins two more hands in a row. The DPT registers this streak and communicates it to the JMS. The JMS activates the jackpot trigger condition, and the RNG determines that the jackpot will indeed be awarded.

Suddenly, all ETGTs at the table display a celebratory animation announcing that the dealer's win streak has triggered the mystery jackpot. The JMS randomly selects Player A as the jackpot winner. The ETGT displays a personalized message congratulating Player A on winning the $5,000 jackpot.

Simultaneously, the Jackpot Display System updates to show the win across all tables in the casino. The dealer, through their interface, is notified of the jackpot win and congratulates Player A. The CMS processes the payout, crediting Player A's account with $5,000.

The JMS resets the jackpot to its starting value, and the DPT resets the dealer performance counter. The ETGTs update to show the new jackpot amount and reset dealer streak counter, ready for the next round of play.

Player Interaction: Players interact with the Mystery Jackpot Linked to Dealer Wins feature primarily through their individual ETGTs. When a player joins the game, they are presented with clear information about the current jackpot amount, the dealer's performance metrics, and the conditions for triggering the jackpot.

Throughout the game, players may view real-time updates on the dealer's performance and the progress towards a potential jackpot trigger. This information is displayed in a dedicated area of the ETGT screen, separate from the main game interface to avoid confusion.

Players may access detailed statistics and historical data about dealer performance and jackpot frequencies through a menu on the ETGT. This allows players to make informed decisions about their gameplay and betting strategies.

When a jackpot is triggered, all ETGTs display an exciting animation. The winning player receives a personalized congratulatory message, while other players see information about the win and encouragement to continue playing for the next jackpot opportunity.

The live dealer plays a notable role in player interaction, verbally announcing their own win streaks and building excitement as the jackpot trigger approaches. Players may interact with the dealer and each other through a chat function on the ETGT, discussing the dealer's performance and sharing in the excitement of potential jackpot triggers.

### Distinguishing Innovative Concepts:

1. Dealer Performance-Based Triggers: Unlike traditional mystery jackpots that are purely random, this system ties the jackpot to tangible game outcomes, creating a more engaging and transparent experience for players.
2. Multi-Table Synergy: The system creates a shared experience across multiple tables by broadcasting dealer performance and jackpot information, fostering a sense of community among players.
3. Dynamic Trigger Conditions: The JMS may adjust the conditions for jackpot triggers based on overall casino performance, time of day, or special promotions, allowing for flexible and strategic management of the jackpot feature.
4. Integrated Dealer-Player Experience: This concept uniquely aligns the interests of the dealer and players, as the dealer's success directly contributes to player jackpot opportunities.
5. Real-Time Performance Analytics: The DPT provides unprecedented real-time analysis of dealer performance, offering valuable data for both players and casino management.

### Distinguishing Inventive Steps:

1. Continuous Dealer Performance Monitoring: The system constantly tracks and analyzes dealer outcomes across multiple games and tables, a novel feature in DETG systems.
2. Adaptive Jackpot Triggering: The JMS uses a combination of dealer performance data and RNG input to create a balanced and exciting jackpot trigger system that is neither too predictable nor too random.
3. Cross-Table Jackpot Opportunity Broadcasting: The system notifies players at other tables when a dealer is approaching a jackpot trigger condition, encouraging movement between tables and maintaining engagement across the casino floor.

35 USC 101 Considerations: The Mystery Jackpot Linked to Dealer Wins concept represents patentable subject matter under 35 USC 101 for several compelling reasons: Firstly, this innovative concept goes beyond an abstract idea by providing a specific technological improvement in the field of electronic gaming systems. It introduces a novel mechanism for triggering jackpots based on real-time analysis of dealer performance, which is a concrete and tangible improvement to the functionality of DETGs.

Secondly, the implementation solves a specific problem in the technological process of operating live dealer electronic game tables. It addresses the issue of disconnection between electronic gaming and the live dealer experience by creating a system that directly links dealer performance to player outcomes in a way that was not previously possible.

Thirdly, the invention integrates the jackpot feature into a practical application that enables a discernible advancement in computer functionality. The system's ability to track dealer performance across multiple tables, process this data in real-time, and use it to influence jackpot triggers represents a significant improvement in the capabilities of electronic gaming systems.

Furthermore, the implementation may require a specific arrangement of electronic components and software algorithms that go beyond generic computer functions. The coordination between ETGTs, the DPT, the JMS, and other casino systems to track dealer performance and trigger jackpots in real-time during live gameplay demonstrates a non-conventional and non-generic arrangement of computer components.

Data Input: The Mystery Jackpot Linked to Dealer Wins feature may require several types of data inputs:
1. Game Outcomes: The dealer inputs the outcome of each game through their interface. This is the primary data point used to track dealer performance.
2. Player Bets: The system tracks player bets to ensure eligibility for jackpot wins and to calculate jackpot contributions.
3. Dealer Identification: At the start of each shift, dealers log into the system, allowing their performance to be tracked individually.
4. Casino Management Inputs: The CMS provides inputs such as jackpot seed amounts, trigger conditions, and payout percentages.
5. RNG Input: Random numbers are generated to add an element of unpredictability to jackpot triggers.

This data input process is unique for DETGs as it combines electronic inputs from the game outcomes with live dealer actions and backend system parameters, creating a seamless integration between the physical and digital aspects of the game.

### Component Interactions and Procedural Steps:

1. Game Outcome Recording: After each game, the dealer inputs the outcome through their interface. This data is sent to the DPT for analysis.
2. Performance Analysis: The DPT continuously analyzes dealer performance, tracking win streaks and other relevant metrics. This information is sent to the JMS and broadcast to all ETGTs.
3. Jackpot Accumulation: As players make bets, the JMS increments the jackpot amount based on a predetermined percentage. The updated jackpot amount is broadcast to all connected ETGTs and the Jackpot Display System.
4. Trigger Condition Monitoring: The JMS constantly monitors the data from the DPT, comparing it to the current trigger conditions.
5. Jackpot Triggering: When trigger conditions are met, the JMS initiates the jackpot sequence: a. It uses the RNG to determine if the jackpot will be awarded. b. If awarded, it selects a winning player from eligible participants. c. It sends win notifications to the winning ETGT and updates all other ETGTs and displays.
6. Payout Processing: The CMS receives payout instructions from the JMS and processes them, updating player balances across all relevant systems.
7. Reset Process: After payouts are confirmed, the JMS resets the jackpot to its starting value and clears the current dealer performance metrics. This reset is communicated to all ETGTs and the Jackpot Display System.

Data Processing: The system processes data through several notable steps:
1. Dealer Performance Calculation: The DPT continuously calculates various performance metrics based on game outcomes.
2. Trigger Probability Calculation: The JMS dynamically calculates the probability of a jackpot trigger based on current dealer performance and predetermined parameters.
3. Jackpot Winner Selection: When a jackpot is triggered, the system uses a fair and random process to select the winner from eligible players.
4. Historical Data Analysis: The system processes historical data on dealer performance and jackpot triggers to refine trigger conditions and inform casino management decisions.

Outputs and Responses: The system provides various outputs:
1. ETGT Displays: Show real-time dealer performance metrics, jackpot amounts, and win notifications.
2. Dealer Interface Updates: Provide feedback on current performance and notify of approaching jackpot trigger conditions.
3. Jackpot Display System: Large screens show jackpot amounts, recent wins, and exceptional dealer performances across multiple tables.
4. Casino Management Reports: The CMS generates reports on jackpot feature performance, dealer statistics, and player engagement rates.

Data Storage and Reporting: The system stores:
1. Detailed Game Outcomes: Linked to specific dealers and time stamps.
2. Jackpot Trigger Events: Including dealer performance at the time of trigger.
3. Player Participation Data: Tracking which players were active during jackpot triggers.
4. Aggregate Performance Data: Long-term storage of dealer and jackpot performance metrics.

This data is reported through regular automated reports and is available for real-time querying through the CMS.

Error Handling and Security Measures:
1. Data Verification: All game outcomes and jackpot triggers are verified through multiple system checks.
2. Redundant Performance Tracking: Notable components like the DPT have redundant systems to ensure accurate performance tracking.
3. Automated Anomaly Detection: The system flags unusual patterns in dealer performance for review.
4. Secure Communication: All data transmissions between system components are encrypted.

End of Interaction: At the end of each dealer shift or gaming session:
1. The system compiles a comprehensive performance report for the dealer.
2. All outstanding jackpots are settled and the jackpot amount is reset for the next session.
3. The DPT resets its counters for the next dealer or session.
4. A session summary is sent to the CMS for record-keeping and analysis.

This end-of-interaction process ensures accurate tracking of dealer performance across multiple sessions and maintains the integrity of the Mystery Jackpot Linked to Dealer Wins feature.

### Innovative Concept 32—Progressive Jackpot for Multiple Rounds

Identification of Concept: This innovative concept introduces a progressive jackpot system that spans multiple game sessions on Dealer-controlled Electronic Table Games (DETGs). Players qualify for the progressive jackpot by participating in consecutive rounds, with each new session contributing to the jackpot pool. This approach enhances player engagement and retention by creating a sense of continuity across gaming sessions. The progressive nature of the jackpot, combined with the multi-round qualification process, differentiates this concept from traditional single-round jackpots in live dealer games. It leverages the electronic nature of DETGs to track player participation and contributions across extended periods, enabling a more complex and rewarding jackpot structure.

### Sequence Diagram Components:

1. Electronic Table Game Terminal (ETGT): The primary interface for players, displaying game information, accepting wagers, and showing jackpot progress.
2. Player A, Player B: Individual players participating in the DETG game and progressive jackpot.
3. Dealer Interface: Used by the live dealer to manage game flow and interact with the jackpot system.
4. Jackpot Management System (JMS): Central system managing jackpot calculations, eligibility, and triggers.
5. Player Tracking System (PTS): Tracks player activity, contributions, and eligibility across multiple rounds.
6. Game Server: Manages game logic and outcomes for the DETG.
7. Casino Management System (CMS): Oversees overall casino operations and integrates various subsystems.
8. Display System: Large screens or integrated displays showing jackpot amounts and eligibility status.

Implementation Details: The Electronic Table Game Terminal is configured with specialized software to interface with the Jackpot Management System and Player Tracking System. This software tracks each player's participation across multiple rounds, recording their wagers and contributions to the progressive jackpot pool. The ETGT uses a secure communication protocol to transmit this data in real-time to the JMS and PTS.

A unique feature of this implementation is the “session continuity tracker” within the ETGT. This component assigns each player a unique session ID that persists across multiple rounds, even if the player temporarily leaves the table. The session continuity tracker uses a combination of player card data, biometric information (if available), and seat position to maintain accurate player identification across sessions.

The ETGT also incorporates a “contribution visualizer” on its display. This feature shows players their current contribution level to the progressive jackpot, their streak of consecutive rounds played, and their progress towards jackpot eligibility thresholds. This real-time feedback mechanism is notable for maintaining player engagement and is not typically found in traditional live dealer games.

To enable seamless multi-round tracking, the ETGT interfaces with the Game Server to synchronize round completions with jackpot contribution updates. This synchronization ensures that players' contributions are accurately reflected even in fast-paced game environments.

Example Walk-through Scenario: Player A sits down at a DETG blackjack table and inserts their player card. The ETGT recognizes the player and assigns them a unique session ID. Player A begins playing and opts into the progressive jackpot by placing a side bet. As each round concludes, the ETGT updates Player A's contribution to the jackpot pool and streak count.

After 10 rounds, Player A decides to take a break. The session continuity tracker maintains Player A's progress. When Player A returns an hour later, they are seamlessly reintegrated into their previous session. The contribution visualizer shows Player A that they are now eligible for a higher tier of the progressive jackpot due to their continued play.

Meanwhile, Player B joins the table and also opts into the jackpot. The Display System shows both players' progress and the current jackpot amount. As more rounds are played, the jackpot grows, and both players see their potential winnings increase.

After 25 rounds of play across multiple hours, the JMS determines that a jackpot trigger condition has been met. The ETGT displays alert both Player A and Player B that they are eligible for the jackpot based on their sustained participation. The Dealer Interface prompts the live dealer to initiate the jackpot win sequence, creating an exciting moment for all players at the table.

Player Interaction: Players interact with the progressive jackpot system primarily through the ETGT interface. At the start of each session, players have the option to participate in the progressive jackpot by placing a designated side bet. The ETGT provides clear instructions on how to opt-in and displays the current jackpot amount and any eligibility requirements.

Throughout their play, players may view their contribution level, consecutive round count, and progress towards different jackpot tiers through the contribution visualizer on the ETGT display. This real-time feedback encourages continued play and engagement with the jackpot feature.

Players may temporarily leave the table and return, with the session continuity tracker ensuring their progress is maintained. This flexibility is a notable differentiator from traditional live dealer games, where leaving the table often resets any progress towards bonuses or jackpots.

The ETGT also allows players to view historical data of their jackpot contributions and near-misses, providing a sense of progress even across multiple visits to the casino. This long-term engagement feature is uniquely possible due to the electronic nature of DETGs and is not feasible in traditional live dealer setups.

Distinguishing Innovative Concepts: This progressive jackpot system for multiple rounds introduces several novel concepts that differentiate it from conventional ETGTs and EGMs:
1. Session Continuity Tracking: Unlike traditional systems where player progress resets upon leaving the table, this system maintains player eligibility and contributions across multiple sessions, even with breaks in play. This is achieved through advanced player identification and data persistence techniques unique to DETGs.
2. Multi-Round Contribution Visualization: The real-time display of a player's contribution level, streak, and progress towards jackpot tiers is a novel feature that leverages the digital interface of DETGs. This level of detailed, personalized feedback is not possible in traditional live dealer games.
3. Adaptive Eligibility Thresholds: The system dynamically adjusts eligibility thresholds based on overall player participation and jackpot size, ensuring the jackpot remains attractive and achievable. This adaptive approach is uniquely suited to the data processing capabilities of DETGs.
4. Cross-Session Jackpot Persistence: The ability to maintain jackpot progress across multiple casino visits is a distinguishing feature enabled by the integration of DETGs with casino-wide player tracking systems.
5. Dealer-Integrated Jackpot Triggers: The involvement of the live dealer in jackpot win sequences combines the excitement of live dealer interaction with the precision of electronic jackpot management, a unique hybrid approach only possible in DETGs.

### Distinguishing Inventive Steps:

1. Dynamic Session Linking: The system employs a novel algorithm to link separate playing sessions into a continuous streak for jackpot eligibility. This algorithm considers factors such as time between sessions, total wager amount, and consistency of play style to determine if separate sessions should be treated as continuous for jackpot purposes.
2. Adaptive Contribution Weighting: Unlike simple cumulative contribution systems, this jackpot employs a sophisticated weighting system that adjusts the value of each contribution based on factors such as current jackpot size, time of day, and overall casino activity. This ensures that the jackpot grows in a manner that maintains player interest and casino profitability.
3. Multi-Tier Eligibility Calculation: The system continuously calculates a player's eligibility for multiple jackpot tiers simultaneously, using a complex set of criteria including consecutive rounds played, total amount wagered, and frequency of visits. This multi-tiered approach creates multiple engagement points for players, encouraging longer and more frequent play.

35 USC 101 Considerations: The technical implementation of this Progressive Jackpot for Multiple Rounds concept presents a strong case for patentable subject matter under 35 USC 101:
(a) This innovative concept goes beyond a mere abstract idea by capturing a specific improvement over prior art progressive jackpot systems. The multi-round, multi-session tracking and adaptive eligibility calculations represent a concrete technological solution to the problem of maintaining player engagement across extended periods in casino gaming.
(b) The concept is directed to an improvement in computer functionality which solves a problem in the existing technological process of electronic table games. Specifically, it addresses the challenge of integrating the continuous nature of jackpot accumulation with the discontinuous nature of player sessions, a problem unique to the intersection of electronic gaming and live dealer interactions.
(c) The implementation integrates the jackpot improvement into a practical application that enables a discernible advancement in computer functionality. The real-time processing of player data across multiple sessions, adaptive adjustment of jackpot parameters, and seamless integration with live dealer interactions represent a significant technological advancement over traditional jackpot systems.

The system's ability to maintain complex player histories, calculate multi-tiered eligibilities in real-time, and provide immediate feedback through advanced visualization techniques demonstrates a level of computational sophistication that goes beyond generic computer implementation. These features work together to create a novel gaming experience that is inextricably tied to the technological capabilities of DETGs, thus meeting the criteria for a patent-eligible improvement to gaming technology.

Data Input: The system may require various types of data inputs from players and other casino systems:
1. Player Identification: Players input their unique identifiers through player cards, biometric scanners, or manual entry on the ETGT.
2. Wager Information: The ETGT captures detailed wager data for each round, including main game bets and specific jackpot side bets.
3. Game Outcomes: Results of each game round are input from the Game Server to the ETGT and JMS.
4. Dealer Actions: The Dealer Interface captures dealer inputs related to game flow and jackpot-related actions.
5. Time Stamps: Precise timing data for each action and round is notable for maintaining accurate session continuity.
6. Player Preferences: Players may input preferences for jackpot notifications and visualization options. This comprehensive data collection enables the novel multi-round tracking and personalized jackpot experience unique to this DETG implementation.

### Component Interactions and Procedural Steps:

1. Player Registration: The ETGT interfaces with the PTS to register a player's session start, creating or retrieving a unique session ID.
2. Wager Processing: For each round, the ETGT sends wager data to the Game Server and JMS simultaneously.
3. Contribution Calculation: The JMS calculates the player's jackpot contribution based on the wager and current jackpot parameters.
4. Eligibility Update: The JMS updates the player's eligibility status across multiple jackpot tiers, considering their current streak and historical data.
5. Display Update: The ETGT receives updated jackpot and eligibility information from the JMS and updates its display.
6. Session Continuity Check: When a player leaves and returns, the ETGT queries the PTS to determine if the new session should be linked to the previous one.
7. Jackpot Trigger Evaluation: After each round, the JMS evaluates if any jackpot trigger conditions have been met.
8. Dealer Notification: If a jackpot is triggered, the Dealer Interface alerts the dealer to initiate the win sequence.
9. Payout Processing: The JMS communicates with the CMS to process jackpot payouts and update financial systems.

This intricate interaction between components enables the seamless integration of the progressive jackpot with the live dealer experience, a notable novelty of this DETG implementation.

Data Processing: The system performs several notable processing steps:
1. Contribution Aggregation: The JMS aggregates contributions across multiple rounds and sessions, applying the adaptive weighting algorithm.
2. Eligibility Computation: Complex calculations determine a player's eligibility across multiple jackpot tiers in real-time.
3. Streak Analysis: The system analyzes the continuity of play sessions to determine valid streaks for bonus eligibility.
4. Jackpot Growth Modeling: Predictive algorithms model jackpot growth to optimize trigger conditions and maintain player interest.
5. Real-time Odds Calculation: The system continuously updates the odds of winning for each player based on their current eligibility status.

These processing steps enable the dynamic and personalized nature of the jackpot experience, distinguishing it from static jackpot systems in traditional live dealer games.

Outputs and Responses: The system provides various outputs to players, dealers, and casino management:
1. Player Displays: ETGTs show current jackpot amounts, personal contribution levels, streak counts, and eligibility status for different tiers.
2. Dealer Interface: Alerts dealers to jackpot-related events and guides them through win sequences.
3. Casino Management Reports: Detailed analytics on jackpot performance, player engagement metrics, and financial impacts.
4. Marketing Integrations: Targeted promotional messages based on players' jackpot participation history.
5. Jackpot Win Celebrations: Coordinated audio-visual displays across multiple ETGTs to celebrate jackpot wins.

These outputs create a rich, interactive experience that blends the excitement of live dealer games with the information density of electronic gaming.

Data Storage and Reporting: The system stores extensive data to support its multi-round, multi-session functionality:
1. Player Contribution History: Detailed records of each player's contributions, stored in the PTS for long-term analysis.
2. Jackpot Growth Trends: Historical data on jackpot accumulation rates and win frequencies, used for future optimizations.
3. Session Linkage Data: Information on how separate playing sessions were linked, supporting audit trails and dispute resolution.
4. Regulatory Compliance Reports: Automated generation of reports required by gaming authorities, detailing jackpot mechanics and payouts.

This comprehensive data storage enables sophisticated trend analysis and supports the system's ability to provide personalized experiences across multiple casino visits.

Error Handling and Security Measures: The system incorporates robust error handling and security features:
1. Contribution Verification: Real-time cross-checking of contribution calculations between the ETGT and JMS to prevent discrepancies.
2. Session Authentication: Multi-factor authentication for high-value jackpots to prevent fraud.
3. Failover Systems: Redundant JMS servers to ensure continuous operation even if primary systems fail.
4. Encryption: End-to-end encryption of all jackpot-related data transmissions to protect player information and game integrity.

These measures ensure the integrity of the jackpot system, notable for maintaining player trust in the multi-round progressive format.

End of Interaction: As a gaming session concludes:
1. Session Summary: Players receive a detailed summary of their jackpot contributions and current eligibility status.
2. State Persistence: The system saves the player's current streak and eligibility data for potential continuation in future sessions.
3. Jackpot Reset: If a jackpot was won, the system resets to its base amount, updating all connected ETGTs.
4. Analytics Update: The session data is integrated into the casino's analytics systems for long-term trend analysis and marketing purposes.

This comprehensive end-of-session process ensures a smooth transition between playing sessions, supporting the novel multi-round nature of the jackpot system.

### Innovative Concept 33—Location-Based Jackpot Linked to Player'S Physical Location

Identification of Concept: This innovative concept introduces a location-based jackpot feature for Dealer-controlled Electronic Table Games (DETGs) where specific casino floors or regions contribute differently to the jackpot pool. The system utilizes advanced positioning technology integrated into the DETGs and player tracking systems to determine players' exact locations within the casino. Based on these locations, the system dynamically adjusts jackpot contribution rates, eligibility criteria, and potential payouts. This concept leverages the unique capabilities of DETGs to create a more immersive and interactive jackpot experience that encourages player movement and exploration within the casino environment.

### Sequence Diagram Components:

1. Electronic Table Game Terminal (ETGT): The primary player interface, equipped with location-sensing technology.
2. Player A, Player B: Individual players participating in the DETG games and location-based jackpot.
3. Location Tracking System (LTS): Advanced system using a combination of WiFi, Bluetooth, and RFID to pinpoint player locations.
4. Jackpot Management System (JMS): Central system managing jackpot calculations, eligibility, and triggers based on location data.
5. Player Tracking System (PTS): Tracks player activity and links it with location data.
6. Casino Floor Mapping System (CFMS): Digital representation of the casino floor, divided into zones with different jackpot attributes.
7. Dynamic Display System (DDS): Network of displays throughout the casino showing location-specific jackpot information.
8. Dealer Interface: Used by live dealers to interact with the location-based jackpot system.

Implementation Details: The Electronic Table Game Terminal is equipped with integrated location sensors and communicates with the Location Tracking System to determine its precise position on the casino floor. This location data is continuously updated and sent to the Jackpot Management System.

A notable feature of this implementation is the “Zone-Based Contribution Modifier” within the ETGT software. This component adjusts the rate at which a player's wagers contribute to the jackpot pool based on their current location. For example, players in a designated “high-contribution zone” may see 5% of their wagers go to the jackpot, while those in a “standard zone” contribute 3%.

The ETGT also incorporates a “Location-Aware Jackpot Visualizer” on its display. This feature shows players a map of the casino floor with real-time updates on jackpot sizes and contribution rates for different areas. It also highlights “hot zones” where jackpot triggers are more to occur.

To enable seamless tracking as players move between tables, the system uses a “Continuous Eligibility Tracker”. This component ensures that players maintain their jackpot eligibility and contributions even when changing tables, as long as they remain within defined casino zones.

The implementation leverages the networked nature of DETGs to create a “Cross-Table Jackpot Linking” feature. This allows for the creation of location-specific mini-jackpots that may be shared among nearby tables, fostering a sense of community among players in the same area.

Example Walk-through Scenario: Player A enters the casino and approaches a DETG blackjack table in the “standard zone”. Upon sitting down and inserting their player card, the ETGT recognizes them and displays their current location on the casino map, along with the standard 3% jackpot contribution rate for that area.

As Player A plays, they notice on the Location-Aware Jackpot Visualizer that a nearby “high-contribution zone” offers a 5% contribution rate and higher jackpot amounts. After a few rounds, Player A decides to move to a DETG in that zone.

Upon arriving at the new table, the ETGT immediately recognizes Player A and seamlessly transfers their accumulated jackpot contributions. The display updates to show the new 5% contribution rate and the larger local jackpot pool.

Meanwhile, Player B is playing at a DETG in a “variable rate zone” where the contribution percentage fluctuates based on overall casino activity. The Dynamic Display System alerts all players in the zone that the contribution rate has temporarily increased to 7% due to high activity, encouraging more play.

As both players continue to play, the Cross-Table Jackpot Linking feature activates, creating a shared mini-jackpot among the tables in their immediate vicinity. This creates excitement and a sense of community among the players.

After several hours of play across different zones, the JMS determines that Player A has triggered a location-based jackpot. The Dealer Interface alerts the live dealer, who initiates a special location-themed win celebration sequence on nearby DETGs and the Dynamic Display System.

Player Interaction: Players interact with the location-based jackpot system primarily through the ETGT interface and by physically moving around the casino floor. The Location-Aware Jackpot Visualizer on each ETGT allows players to see real-time updates on jackpot sizes and contribution rates for different areas of the casino.

Players may strategically choose their playing locations based on the current jackpot conditions displayed. The system encourages exploration by occasionally creating “pop-up” high-contribution zones or special jackpot events in different areas of the casino.

The ETGT interface also provides players with a personal “jackpot journey” map, showing their movement history and how it has affected their jackpot contributions and eligibility. This gamification element adds an extra layer of engagement to the casino experience.

Players may opt to receive notifications on their mobile devices (through a linked casino app) about nearby jackpot opportunities or when they enter zones with special jackpot conditions.

Distinguishing Innovative Concepts:
1. Dynamic Location-Based Contribution Rates: Unlike traditional systems with fixed contribution rates, this system adjusts rates based on a player's real-time location within the casino.
2. Seamless Cross-Table Jackpot Transfer: The ability to maintain jackpot contributions and eligibility while moving between tables is a novel feature enabled by the integration of location tracking with DETGs.
3. Zone-Based Jackpot Multipliers: The system may apply multipliers to jackpot wins based on the zone in which they are triggered, adding an extra element of excitement and strategy to table selection.
4. Geofenced Jackpot Eligibility: Certain jackpots or jackpot tiers may only be available to players within specific casino areas, encouraging movement and exploration.
5. Real-Time Casino Floor Heat Mapping: The system generates and displays live heat maps showing jackpot activity across the casino floor, a feature uniquely possible with the data-rich environment of DETGs.

### Distinguishing Inventive Steps:

1. Continuous Location-Eligibility Calculation: The system employs a novel algorithm that continuously calculates a player's jackpot eligibility based on their real-time location and movement history within the casino.
2. Dynamic Zone Definition: Instead of using fixed zone boundaries, the system may dynamically redefine zones based on current casino floor activity, time of day, or special events.
3. Multi-Sensor Triangulation for Precise Positioning: The system uses a combination of WiFi, Bluetooth, and RFID signals to achieve highly accurate player positioning, notable for fair implementation of location-based features.

35 USC 101 Considerations: The technical implementation of this Location-Based Jackpot concept presents a strong case for patentable subject matter under 35 USC 101:
(a) This innovative concept goes beyond a mere abstract idea by capturing a specific technological improvement in casino gaming systems. The integration of real-time location tracking with jackpot management represents a concrete solution to the challenge of creating more engaging and interactive casino experiences.
(b) The concept is directed to an improvement in computer functionality that solves a problem in the existing technological process of electronic table games. Specifically, it addresses the challenge of linking physical casino layout with digital gaming systems in a way that enhances player engagement and casino operations.
(c) The implementation integrates the location-based jackpot improvement into a practical application that enables a discernible advancement in gaming technology. The real-time processing of location data, dynamic adjustment of jackpot parameters, and seamless integration with player movement represent significant technological advancements over traditional static jackpot systems.

The system's ability to maintain precise location tracking, calculate location-based eligibilities in real-time, and provide immediate feedback through advanced visualization techniques demonstrates a level of technological sophistication that goes beyond generic computer implementation. These features work together to create a novel gaming experience that is inextricably tied to the technological capabilities of DETGs and advanced location tracking systems, thus meeting the criteria for a patent-eligible improvement to gaming technology.

### Data Input:

1. Player Location: Continuous real-time location data from the LTS.
2. Player Identification: Input through player cards or biometric systems at each ETGT.
3. Wager Information: Detailed betting data captured by each ETGT.
4. Zone Definitions: Current zone boundaries and attributes from the CFMS.
5. Casino Activity Metrics: Overall casino floor activity levels to inform dynamic zone adjustments.
6. Dealer Inputs: Jackpot-related actions input through the Dealer Interface.

This comprehensive data collection enables the novel location-based jackpot experience unique to this DETG implementation.

### Component Interactions and Procedural Steps:

1. Location Tracking: The LTS continuously updates player positions, sending data to the JMS.
2. Zone Calculation: The JMS cross-references player locations with the CFMS to determine applicable jackpot rules.
3. Contribution Rate Adjustment: The ETGT receives updated contribution rates from the JMS based on current location.
4. Eligibility Update: The JMS recalculates player eligibility for various jackpots as they move between zones.
5. Display Updates: ETGTs and the DDS receive real-time updates on jackpot sizes and hot zones.
6. Cross-Table Linking: The JMS manages the creation and updating of location-specific mini-jackpots.
7. Jackpot Trigger Evaluation: The JMS continuously evaluates trigger conditions, considering both standard and location-specific criteria.
8. Win Sequence Initiation: Upon a jackpot win, the JMS coordinates with the Dealer Interface and DDS to initiate location-appropriate celebration sequences.

### Data Processing:

1. Location Data Filtering: Algorithms to filter and smooth location data for accurate player tracking.
2. Dynamic Zone Analysis: Real-time analysis of casino floor activity to optimize zone boundaries and attributes.
3. Contribution Rate Calculation: Complex calculations to determine appropriate jackpot contribution rates based on location and current casino conditions.
4. Eligibility Computation: Continuous recalculation of player eligibility across multiple jackpot tiers as they move through the casino.
5. Heat Map Generation: Real-time processing of player density and jackpot activity data to create informative heat maps.

### Outputs and Responses:

1. ETGT Displays: Real-time updates on player location, applicable jackpot rates, and nearby opportunities.
2. Dynamic Display System: Large screens throughout the casino showing zone-specific jackpot information and heat maps.
3. Mobile Notifications: Alerts sent to players' devices about nearby jackpot opportunities or zone changes.
4. Dealer Interface: Information on location-specific jackpot conditions and win sequences.
5. Management Reports: Detailed analytics on how the location-based system affects player behavior and casino performance.

### Data Storage and Reporting:

1. Player Movement Patterns: Historical data on how players navigate the casino floor in response to jackpot incentives.
2. Zone Performance Metrics: Data on the effectiveness of different zone configurations and jackpot rates.
3. Jackpot Win Distribution: Analysis of how jackpot wins correlate with specific locations or movement patterns.
4. Regulatory Compliance Data: Detailed records of location-based jackpot mechanics to ensure fairness and transparency.

### Error Handling and Security Measures:

1. Location Data Verification: Cross-checking of location data from multiple sensors to prevent spoofing.
2. Fail-Safe Zone Defaults: Predefined default jackpot rates in case of location tracking system failures.
3. Player Privacy Controls: Options for players to limit the precision of their tracked location for jackpot purposes.
4. Anti-Collusion Measures: Algorithms to detect and prevent coordinated player movements aimed at exploiting the system.

### End of Interaction:

1. Location History Summary: Players receive a map showing their movement and how it affected their jackpot participation.
2. Zone-Specific Rewards: Issuance of rewards or bonuses based on the player's exploration of different casino areas.
3. Jackpot Contribution Transfer: Any unused jackpot contributions are stored in the player's account, maintaining eligibility for their next visit.
4. Analytics Update: The system integrates the session's location and jackpot data into long-term trend analysis for continuous optimization of the casino floor layout and jackpot zone configurations.

This comprehensive end-of-session process ensures that the location-based jackpot system not only enhances the immediate gaming experience but also contributes to ongoing improvements in casino operations and player engagement strategies.

### Innovative Concept 34—Random Jackpot Activation Button

Identification of Concept: This innovative concept introduces a novel feature for live dealer-controlled multiplayer games with mystery jackpot functionality, specifically designed for implementation in live dealer-streamed electronic game table systems and Dealer-controlled Electronic Table Games (DETGs). The specific innovation is a dedicated random jackpot activation button available to the live dealer, which may trigger random jackpot activation events during gameplay. This concept enhances the excitement and unpredictability of the gaming experience by allowing the dealer to initiate jackpot opportunities at their discretion, creating a unique blend of human interaction and random chance within the electronic gaming environment. The feature may be implemented across various DETG systems, including electronic blackjack, baccarat, and roulette tables, adding an extra layer of anticipation and potential rewards for players engaged in these games.

Sequence Diagram Components: The notable components involved in this procedural flow include:
1. Electronic Table Game Terminal (ETGT): The primary interface for players, displaying game information, jackpot status, and player actions.
2. Dealer Control Panel: A specialized interface for the dealer, featuring the random jackpot activation button and other game control elements.
3. Player A and Player B: Representative players participating in the game and eligible for jackpot wins.
4. Random Number Generator (RNG): A secure system component that ensures the randomness of jackpot activation and prize determination.
5. Jackpot Management System: A backend component that tracks jackpot pools, eligibility, and payouts.
6. Game Server: Manages game logic, rules, and coordinates communication between ETGTs and other system components.
7. Player Tracking System: Monitors player activity, manages account information, and tracks loyalty points.
8. Casino Management System: Oversees overall casino operations, including financial transactions and reporting.

Implementation Details: To implement this concept in live dealer electronic game table systems and DETGs, each Electronic Table Game Terminal is equipped with a specialized dealer interface featuring the random jackpot activation button. This button is securely connected to the game server and jackpot management system via encrypted channels. The dealer control panel is designed with a user-friendly interface, allowing the dealer to easily activate the jackpot feature without disrupting the flow of the game. When pressed, the button triggers a series of backend processes:
1. The action is logged and time-stamped for security and auditing purposes.
2. The game server communicates with the RNG to determine if a jackpot event should be triggered based on pre-set probabilities.
3. If triggered, the jackpot management system is notified to prepare for a potential payout.
4. The ETGTs are updated in real-time to display jackpot activation animations and information to all players.

This implementation differs from conventional ETGTs by introducing a human element to jackpot initiation, creating a hybrid system that combines the excitement of live dealer interaction with the precision and fairness of electronic gaming systems. The random nature of the activation, even after the button press, ensures fairness and compliance with gaming regulations while adding an element of showmanship to the dealer's role.

Example Walk-through Scenario: At a live dealer electronic baccarat table with six players, the dealer notices a lull in excitement and decides to activate the random jackpot feature. She presses the dedicated button on her control panel, which immediately triggers a visually appealing animation across all connected ETGTs, alerting players to the potential jackpot opportunity. The RNG quickly determines that this activation will result in a jackpot event. The game server communicates this to the jackpot management system, which selects a prize tier based on current jackpot pools and probabilities.

In this scenario, a “Mini Jackpot” of $500 is selected. The ETGTs display a spinning wheel animation, building suspense as it slows to a stop, revealing the Mini Jackpot win. Simultaneously, the player tracking system identifies all eligible players based on their current bets and account status. In this case, four out of the six players qualify. The jackpot management system then randomly selects one of these players as the winner.

Player A is chosen and receives a celebratory animation on their ETGT, along with congratulatory messages from the dealer. The casino management system processes the $500 payout, updating Player A's balance in real-time. All other players receive a notification about the win, maintaining engagement and excitement at the table. The dealer acknowledges the win verbally, adding a personal touch to the electronic notification. The game then smoothly transitions back to regular play, with the jackpot pools adjusting accordingly for future activations.

Player Interaction: Players interact with this feature primarily through their individual ETGTs. Upon sitting at the table, they are greeted with information about the random jackpot feature, including current jackpot amounts and eligibility requirements. As they place bets and play the primary game, their ETGT continuously updates to show their jackpot eligibility status. When the dealer activates the random jackpot button, all ETGTs instantly react, capturing players' attention with dynamic animations and sound effects.

Players do not need to take any additional actions to participate in the jackpot beyond their regular gameplay. This seamless integration ensures that the primary game's pace is maintained while adding an extra layer of excitement. If a player wins a jackpot, their ETGT provides an immersive celebration experience, potentially including haptic feedback, personalized messaging, and options to share their win on social media directly from the terminal. Non-winning players receive engaging “near-miss” animations or information about how close they were to winning, encouraging continued play.

Distinguishing Innovative Concepts: This concept introduces several novel elements that set it apart from conventional ETGTs and EGMs:
1. Dealer-Initiated Random Events: Unlike traditional systems where jackpots are entirely system-controlled, this concept allows human dealers to influence the timing of jackpot opportunities, creating a unique hybrid of live and electronic gaming.
2. Seamless Integration of Live and Electronic Elements: The system bridges the gap between the personal touch of live dealer games and the precision of electronic systems, offering a best-of-both-worlds scenario that's particularly appealing in markets like Macau where personal interaction is highly valued.
3. Dynamic Jackpot Eligibility: The system may adjust jackpot eligibility in real-time based on current bets, player status, and other factors, allowing for more flexible and engaging jackpot structures than traditional fixed-eligibility systems.
4. Multi-Player Jackpot Experience: Unlike single-player EGMs, this system creates a shared experience among all players at the table, fostering a sense of community and shared excitement.
5. Adaptive Jackpot Frequency: The dealer's ability to activate the feature allows for dynamic adjustment of jackpot frequency based on table atmosphere, player engagement levels, and casino preferences, something not possible with fully automated systems.

These concepts collectively enable a more flexible, engaging, and personalized jackpot experience in live dealer electronic game table systems and DETGs, significantly differentiating them from conventional ETGTs and EGMs.

### Distinguishing Inventive Steps:

1. Dealer Jackpot Activation: When the dealer presses the random jackpot activation button, the system logs the action and initiates a secure communication with the RNG and game server. This step introduces a novel human element to electronic jackpot systems, allowing for strategic timing of jackpot opportunities based on the dealer's assessment of table dynamics.
2. Real-Time Eligibility Assessment: Upon jackpot activation, the system performs an instantaneous evaluation of all active players' eligibility based on their current bets, account status, and predefined criteria. This step enables dynamic participation in jackpot events, contrasting with the static eligibility of traditional slot machine jackpots.
3. Multi-Tier Jackpot Selection: If a jackpot is triggered, the system randomly selects from multiple jackpot tiers, each with different probabilities and amounts. This step creates a more diverse and exciting jackpot experience compared to single-jackpot systems, allowing for frequent smaller wins alongside the possibility of larger payouts.

These steps are unique to supporting live dealer electronic game table systems and DETGs, offering a level of flexibility and engagement not possible with conventional EGMs designed for single-player experiences. They enable a seamless blend of live dealer interaction, multiplayer dynamics, and electronic precision, creating a distinctive gaming product particularly suited to markets that value both technological advancement and personal interaction.

35 USC 101 Considerations: The implementation of this innovative concept represents patentable subject matter under 35 USC 101 for several compelling reasons:
(a) This concept goes beyond a mere abstract idea by capturing a specific improvement over prior art in electronic gaming systems. It introduces a tangible and novel mechanism for integrating human decision-making (via the dealer's button press) with complex electronic systems (RNG, real-time eligibility assessment, multi-tier jackpot selection) in a way that creates a new and improved gaming experience.
(b) The innovative concept is directed to an improvement in computer functionality that solves a problem in existing technological processes. Specifically, it addresses the challenge of maintaining the excitement and personal touch of live dealer games while leveraging the precision and fairness of electronic systems. This hybrid approach enhances the functionality of electronic gaming systems by allowing for dynamic, context-aware jackpot activations that respond to real-time table conditions.
(c) The concept integrates the improvement into a practical application that enables a discernible advancement in computer functionality. The system's ability to process dealer input, assess player eligibility in real-time across multiple terminals, and coordinate complex jackpot events across networked devices demonstrates a clear technological improvement. This functionality goes beyond merely implementing an abstract idea on a computer, as it creates a novel gaming ecosystem that was not previously possible with either traditional live games or standalone electronic gaming machines.

Furthermore, the implementation may require specialized gaming hardware and software configurations, including secure communication protocols, real-time data processing, and synchronized multi-display updates. These elements collectively transform the abstract idea of a dealer-initiated jackpot into a specific technological improvement in the field of electronic gaming systems.

Data Input: The system may require various types of data inputs to function effectively:
1. Dealer Input: The primary novel input is the dealer's activation of the random jackpot button. This input is timestamped and securely transmitted to the game server.
2. Player Bet Data: Continuous real-time tracking of each player's current bets, including main game wagers and any side bets, is notable for determining jackpot eligibility.
3. Player Identification: Data from player tracking cards or systems to identify and verify players at each ETGT.
4. Game State Information: Current game phase, results of previous rounds, and other relevant game data.
5. Jackpot Pool Status: Up-to-date information on the current state of all jackpot tiers.
6. Casino Parameters: Configurable settings such as jackpot activation probabilities, eligibility criteria, and payout structures.

This approach differs from conventional ETGTs by incorporating live dealer input as a notable trigger for jackpot events, creating a unique hybrid of human and electronic data inputs. The system's ability to process and act on this diverse data in real-time enables the dynamic and engaging jackpot experience central to this concept.

Component Interactions and Procedural Steps: The implementation of this innovative concept involves complex interactions between various components of the DETG system and the casino gaming network:
1. Dealer Activation: When the dealer presses the random jackpot activation button, the Dealer Control Panel sends an encrypted signal to the Game Server.
2. Game Server Processing: The Game Server logs the activation attempt and communicates with the RNG to determine if a jackpot event should occur.
3. Eligibility Check: If a jackpot event is triggered, the Game Server queries the Player Tracking System and analyzes current bet data from all ETGTs to determine eligible players.
4. Jackpot Selection: The Jackpot Management System is consulted to select the specific jackpot tier to be awarded based on current pools and predefined probabilities.
5. ETGT Updates: The Game Server sends encrypted update messages to all ETGTs, triggering jackpot animations and updating displays.
6. Winner Selection: If applicable, the RNG is used to randomly select a winner from the pool of eligible players.
7. Payout Processing: The Casino Management System is notified to process the payout and update financial records.
8. Player Notification: The winning player's ETGT displays celebratory animations and payout information, while other ETGTs show relevant information to maintain engagement.

Throughout this process, continuous encrypted communication occurs between all components to ensure data integrity and system security. This approach differs from conventional systems by integrating live dealer input with sophisticated real-time electronic gaming systems, creating a unique hybrid experience.

Data Processing: The system performs several notable data processing steps:
1. Jackpot Trigger Calculation: Upon dealer button activation, the RNG generates a random number which is compared against predefined probability thresholds to determine if a jackpot event occurs.
2. Eligibility Computation: The system rapidly processes current bet data and player status information to create a pool of eligible players for each jackpot tier.
3. Jackpot Tier Selection: If a jackpot is triggered, another random number is generated to select the specific jackpot tier based on weighted probabilities.
4. Winner Determination: For jackpots awarded to a single player, a random selection algorithm chooses from the pool of eligible players.
5. Payout Calculation: The system calculates the exact payout amount, considering factors such as split jackpots or bonus multipliers if applicable.

This processing approach is novel in its combination of real-time data from multiple sources (dealer input, player bets, account statuses) to create dynamic jackpot opportunities, differentiating it from more static jackpot systems in conventional ETGTs and EGMs.

Outputs and Responses: The system provides various outputs and responses to players and other components:
1. ETGT Displays: All player terminals update in real-time to show jackpot activations, near-miss information, and win celebrations.
2. Dealer Feedback: The dealer's control panel provides confirmation of button activation and jackpot outcomes.
3. Audio Cues: The system generates appropriate sounds to enhance the excitement of jackpot events.
4. Player Account Updates: Winning players see their account balances updated in real-time on their ETGTs.
5. Jackpot Display Updates: Central jackpot displays are immediately updated to reflect new jackpot amounts.
6. Backend Notifications: The Casino Management System receives detailed event logs for accounting and compliance purposes.

This multi-faceted output system creates a more immersive and engaging experience compared to conventional ETGTs, leveraging the networked nature of the system to provide consistent, exciting feedback across all touchpoints.

Data Storage and Reporting: The system stores various types of data related to the random jackpot feature:
1. Activation Logs: Detailed records of each dealer button activation, including timestamp and outcome.
2. Jackpot Win History: Comprehensive data on all jackpot wins, including winner information, amount, and associated game details.
3. Player Eligibility Snapshots: Periodic recordings of player eligibility status for auditing purposes.
4. Financial Transactions: Detailed logs of all jackpot-related payouts and pool contributions.

This data is securely stored in the casino's central database and may be accessed for generating reports on jackpot performance, dealer activation patterns, and player engagement metrics. The inclusion of dealer-initiated events in these reports provides novel insights not available in conventional ETGT systems.

Error Handling and Security Measures: The system incorporates robust error handling and security measures:
1. Redundant Communication Channels: To ensure dealer button activations are always registered.
2. Encryption: All data transmissions are encrypted to prevent tampering or interception.
3. Activation Cooldown: A brief cooldown period after each activation prevents accidental double-presses.
4. Automated System Checks: Regular integrity checks ensure all components are functioning correctly.
5. Manual Override Protocols: Allow floor managers to address any system anomalies quickly.

These measures are tailored to the unique challenges of a dealer-activated random jackpot system, providing additional layers of security beyond those found in standard ETGTs.

End of Interaction: At the conclusion of a jackpot event, the system:
1. Resets all ETGTs to their standard game display.
2. Updates jackpot pools for the next activation.
3. Logs the complete event details for auditing.
4. Signals the dealer that regular gameplay may resume. This seamless transition maintains the flow of the primary game while setting the stage for future jackpot opportunities, a notable advantage of this hybrid system over conventional ETGTs that typically have more disruptive jackpot cycles.

### Innovative Concept 35—-Adjustable Jackpot Pool Splitting

Identification of Concept: This innovative concept introduces a dynamic and flexible approach to jackpot distribution in live dealer-controlled multiplayer games with mystery jackpot features, specifically designed for implementation in live dealer-streamed electronic game table systems and Dealer-controlled Electronic Table Games (DETGs). The specific innovation lies in the ability of the casino operator to adjust, in real-time, how the jackpot pool is split between individual winners and shared winners based on current player participation and other strategic factors. This concept enhances the adaptability of the jackpot system, allowing casinos to optimize player engagement and satisfaction by tailoring the jackpot distribution to the current gaming environment. The feature may be implemented across various DETG systems, including electronic blackjack, baccarat, and roulette tables, providing a versatile tool for casino management to influence player behavior and maintain interest in jackpot participation.

### Sequence Diagram Components:

1. Electronic Table Game Terminal (ETGT): The primary interface for players, displaying game information, jackpot status, and player actions.
2. Casino Management Interface (CMI): A specialized control panel for casino operators to adjust jackpot splitting parameters.
3. Player A and Player B: Representative players participating in the game and eligible for jackpot wins.
4. Jackpot Management System (JMS): A backend component that tracks jackpot pools, manages split configurations, and handles payouts.
5. Game Server: Manages game logic, rules, and coordinates communication between ETGTs and other system components.
6. Player Tracking System: Monitors player activity, manages account information, and tracks loyalty points.
7. Real-time Analytics Engine: Analyzes current game data, player behavior, and casino metrics to inform jackpot splitting decisions.
8. Notification System: Manages the distribution of jackpot-related information to players and staff.

Implementation Details: To implement this concept in live dealer electronic game table systems and DETGs, each gaming floor is equipped with a centralized Casino Management Interface that communicates with the Jackpot Management System. This interface allows authorized casino personnel to adjust jackpot splitting parameters in real-time. The system is designed with the following notable features:

1. Dynamic Split Ratio Adjustment: Operators may modify the percentage split between individual and shared jackpots based on current gaming floor metrics.

2. Time-based Split Scheduling: Preset split configurations may be scheduled for different times of day or specific events.

3. Game-specific Configurations: Different split ratios may be applied to various game types or individual tables.

4. Player Density Responsiveness: The system may automatically suggest split adjustments based on the number of active players.

5. Historical Performance Analysis: The interface provides data on past jackpot performance to inform decision-making.

This implementation differs from conventional ETGTs by introducing a level of real-time customization to jackpot structures that was previously unavailable. It allows casinos to respond dynamically to player behavior and preferences, potentially increasing overall engagement with jackpot features. The system's ability to adapt to different game types and player densities makes it particularly suitable for diverse gaming environments like those found in Macau, where player preferences may vary significantly throughout the day.

Example Walk-through Scenario: On a busy Saturday night at a Macau casino, the floor manager notices that the electronic baccarat tables are particularly crowded, while the blackjack tables have fewer players. Using the Casino Management Interface, she adjusts the jackpot split for baccarat tables to favor shared wins (70% shared, 30% individual) to capitalize on the social atmosphere. For blackjack, she sets a split favoring individual wins (30% shared, 70% individual) to incentivize more players to join these tables.

As the night progresses, a jackpot is triggered at a baccarat table with eight players. The Jackpot Management System, operating under the new split configuration, allocates 70% of the $10,000 jackpot ($7,000) to be shared among all eligible players at the table, while 30% ($3,000) goes to the primary winner. The Game Server communicates this split to all ETGTs at the table, displaying personalized win amounts to each player.

Meanwhile, at a blackjack table, a player hits a jackpot trigger. Here, the split configuration awards them 70% of the jackpot as an individual prize, with the remaining 30% distributed among other eligible players at the table. This differentiated approach maintains excitement across different game types and table densities.

Throughout the evening, the Real-time Analytics Engine monitors player reactions to these splits, providing data to the floor manager through the CML Based on this feedback, she makes further adjustments to optimize engagement across the gaming floor.

Player Interaction: Players interact with this feature primarily through their individual ETGTs. When joining a table, players are informed of the current jackpot structure, including the potential for individual and shared wins. As they play, their ETGT displays real-time updates on jackpot sizes and their personal eligibility status.

When a jackpot is won, all ETGTs at the affected table instantly update to show the split structure and individual winnings. Winners experience a celebratory animation sequence, while other players receive notifications about their share of the jackpot, if applicable. This immediate feedback loop keeps all players engaged and informed about the jackpot feature.

Players do not need to take any additional actions to participate in the adjusted jackpot structures, their normal gameplay automatically qualifies them based on the current split configuration. This seamless integration ensures that the primary game's pace is maintained while adding an extra layer of excitement and potential reward.

Distinguishing Innovative Concepts:
1. Real-time Jackpot Split Adjustment: Unlike traditional fixed jackpot systems, this concept allows for on-the-fly modifications to jackpot distribution, enabling casinos to respond instantly to floor conditions.
2. Game-Specific Jackpot Structures: The ability to set different split ratios for various game types allows for tailored experiences that match the unique characteristics of each game.
3. Data-Driven Split Optimization: Integration with a Real-time Analytics Engine provides a basis for informed decision-making, potentially increasing the effectiveness of jackpot features in driving player engagement.
4. Scheduled Split Variations: The ability to pre-set split configurations for different times or events allows for automated adaptation to predictable changes in player demographics or behavior.
5. Hybrid Individual/Shared Jackpot Model: By combining individual and shared jackpots in adjustable ratios, this system creates a unique reward structure that may balance personal and communal gaming experiences.

These concepts collectively enable a more flexible and responsive jackpot system in live dealer electronic game table systems and DETGs, significantly differentiating them from conventional ETGTs and EGMs with static jackpot structures.

### Distinguishing Inventive Steps:

1. Dynamic Jackpot Reconfiguration: When an operator adjusts the jackpot split through the CMI, the system securely transmits the new configuration to the Jackpot Management System, which immediately updates its payout algorithms. This step allows for unprecedented flexibility in jackpot management.
2. Context-Aware Split Calculation: Upon a jackpot trigger, the system assesses the current split configuration, game type, and number of eligible players to calculate the exact distribution of the jackpot. This step enables a tailored reward experience that may adapt to various gaming scenarios.
3. Multi-Channel Winner Notification: The system simultaneously notifies the primary winner(s) and all eligible players of their respective shares through individualized ETGT messages, creating a communal yet personalized jackpot experience.

These steps are unique in supporting live dealer electronic game table systems and DETGs, offering a level of customization and engagement not possible with conventional EGMs designed for single-player experiences or static multi-player jackpots. They enable casinos to fine-tune their jackpot offerings to maximize appeal across different player segments and game types, creating a distinctive gaming product particularly suited to diverse markets like Macau.

35 USC 101 Considerations: The implementation of this innovative concept represents patentable subject matter under 35 USC 101 for several compelling reasons:
(a) This concept goes beyond a mere abstract idea by capturing a specific improvement over prior art in electronic gaming systems. It introduces a tangible and novel mechanism for dynamically adjusting jackpot distributions in response to real-world gaming floor conditions, creating a new and improved gaming experience that was not previously possible.
(b) The innovative concept is directed to an improvement in computer functionality that solves a problem in existing technological processes. Specifically, it addresses the challenge of maintaining player engagement across diverse game types and fluctuating player densities by allowing real-time adjustments to jackpot structures. This dynamic approach enhances the functionality of electronic gaming systems by enabling them to adapt to changing conditions in ways that static systems cannot.
(c) The concept integrates the improvement into a practical application that enables a discernible advancement in computer functionality. The system's ability to process real-time analytics, adjust complex payout algorithms on the fly, and coordinate these changes across multiple networked devices demonstrates a clear technological improvement. This functionality goes beyond merely implementing an abstract idea on a computer, as it creates a responsive gaming ecosystem that continuously optimizes itself based on current conditions.

Furthermore, the implementation may require specialized gaming hardware and software configurations, including secure real-time communication protocols, dynamic payout calculation algorithms, and synchronized multi-display updates. These elements collectively transform the abstract idea of adjustable jackpots into a specific technological improvement in the field of electronic gaming systems.

Data Input: The system may require various types of data inputs to function effectively:
1. Operator Commands: Real-time adjustments to jackpot split ratios input through the Casino Management Interface.
2. Player Participation Data: Continuous tracking of the number of active players at each table and game type.
3. Bet Information: Real-time data on bet amounts and types for each player.
4. Game Outcome Data: Results of each game round to determine jackpot triggers.
5. Player Identification: Data from player tracking systems to identify eligible players for jackpot participation.
6. Time and Event Information: Current time and any special event flags that may influence jackpot configurations.
7. Historical Performance Metrics: Past data on jackpot performance and player engagement for different split configurations.

This approach differs from conventional ETGTs by incorporating a much broader range of real-time inputs to inform jackpot structures, allowing for a more responsive and optimized gaming experience.

### Component Interactions and Procedural Steps:

1. Operator Adjustment: The casino operator inputs new split parameters via the CMI.
2. Configuration Transmission: The CMI securely transmits the new configuration to the Jackpot Management System.
3. JMS Update: The JMS updates its internal algorithms and notifies the Game Server of the changes.
4. ETGT Synchronization: The Game Server pushes updates to all affected ETGTs, updating jackpot information displays.
5. Continuous Monitoring: The Real-time Analytics Engine constantly analyzes player data and game metrics.
6. Jackpot Trigger: When a jackpot is triggered, the Game Server notifies the JMS.
7. Split Calculation: The JMS calculates the split based on current configuration and player eligibility.
8. Payout Distribution: The JMS instructs the Game Server on how to distribute winnings.
9. Player Notification: ETGTs display personalized win information to all affected players.
10. Analytics Update: The Real-time Analytics Engine logs the event and updates its recommendations for future splits.

This process flow is novel in its ability to dynamically adjust and implement complex jackpot structures across multiple games and tables in real-time, a capability not present in conventional ETGT systems.

Data Processing: The system performs several notable data processing steps:
1. Split Ratio Calculation: The JMS continuously recalculates potential payouts based on current split configurations and jackpot sizes.
2. Eligibility Determination: For each game round, the system processes bet data to determine which players qualify for various jackpot tiers.
3. Real-time Analytics: Constant analysis of player behavior, game performance, and jackpot engagement to inform split recommendations.
4. Payout Computation: Upon jackpot trigger, rapid calculation of individual and shared payouts based on current split ratios and eligible players.
5. Trend Analysis: Processing of historical data to identify patterns in player response to different split configurations.

This processing approach is novel in its combination of real-time game data, player behavior analytics, and dynamic payout algorithms, allowing for a level of jackpot customization not possible in conventional systems.

### Outputs and Responses:

1. ETGT Displays: Real-time updates of jackpot sizes, split information, and personalized win amounts.
2. CMI Feedback: Continuous updates on jackpot performance and player engagement metrics.
3. Winner Notifications: Personalized messages and animations for jackpot winners and participants.
4. Staff Alerts: Notifications to floor staff about significant jackpot events or recommended configuration changes.
5. Financial System Updates: Real-time transmission of payout information to casino accounting systems.
6. Analytics Reports: Detailed reports on jackpot performance and player behavior for management review.

This multi-faceted output system creates a more responsive and informative jackpot experience compared to conventional ETGTs, leveraging real-time data to enhance both player experience and operational efficiency.

Data Storage and Reporting: The system stores various types of data related to the adjustable jackpot feature:
1. Split Configuration History: Detailed logs of all split ratio adjustments, including timestamps and operator information.
2. Jackpot Win Records: Comprehensive data on all jackpot wins, including individual and shared payout amounts.
3. Player Engagement Metrics: Aggregated data on player participation rates and betting patterns in response to different split configurations.
4. Performance Analytics: Long-term trend data on the effectiveness of various split strategies across different game types and time periods.

This data is securely stored and may be used to generate detailed reports on jackpot performance, player behavior, and the impact of different split strategies on overall gaming floor performance.

### Error Handling and Security Measures:

1. Configuration Verification: Double-check mechanisms to ensure split adjustments are within acceptable parameters.
2. Redundant Communication Channels: To ensure split updates are consistently applied across all affected games.
3. Automated Failsafes: Systems to prevent accidental or unauthorized changes to jackpot structures.
4. Real-time Monitoring: Continuous system checks to detect any discrepancies in jackpot calculations or distributions.
5. Audit Trails: Detailed logging of all system actions for regulatory compliance and troubleshooting.

These measures are tailored to the unique challenges of a dynamically adjustable jackpot system, providing additional layers of security and reliability beyond those found in standard ETGTs.

End of Interaction: After a jackpot event or at the end of a configured time period:
1. The system reverts to default split configurations if applicable.
2. Final performance metrics are logged and reported to the CMI.
3. The Real-time Analytics Engine updates its recommendation algorithms based on the most recent data.
4. All ETGTs are synchronized to display the current jackpot information for the next gaming period.

This seamless transition ensures continuous optimization of the jackpot feature while maintaining transparency for players and operational efficiency for the casino.

### Innovative Concept 36—Dealer-Chosen Jackpot Multiplier

Identification of Concept: This innovative concept introduces a dynamic element to the mystery jackpot system in live dealer-controlled multiplayer games implemented at Electronic Table Game Terminals (ETGTs). The dealer is empowered to apply a multiplier to the jackpot winnings under specific, pre-set game conditions. This feature adds an exciting layer of unpredictability and engagement to the game, as the dealer becomes an active participant in potentially increasing the jackpot amount. The concept is designed to work seamlessly with existing DETG systems, enhancing the interactive experience between the dealer and players while maintaining the integrity and fairness of the game.

### Sequence Diagram Components:

1. Electronic Table Game Terminal (ETGT): The primary interface for players, displaying game information, accepting wagers, and showing jackpot details.
2. Player A, Player B: Individual players participating in the game and eligible for the jackpot.
3. Live Dealer Interface: A specialized terminal used by the dealer to manage the game and activate the jackpot multiplier.
4. Jackpot Control System: A backend component that manages jackpot calculations, eligibility, and multiplier applications.
5. Random Number Generator (RNG): Ensures the fairness of multiplier selection when activated by the dealer.
6. Game Server: Manages game logic, rules, and coordinates communication between all components.
7. Player Tracking System: Monitors player activity and eligibility for jackpots.
8. Jackpot Display System: Large screens visible to all players showing current jackpot amounts and any applied multipliers.
9. Casino Management System: Oversees all gaming operations and interfaces with the Jackpot Control System.

Implementation Details: The Electronic Table Game Terminal is configured with a specialized software module that interfaces with the Jackpot Control System. This module allows real-time communication of jackpot status, multiplier availability, and player eligibility. The Live Dealer Interface is equipped with a secure, touch-sensitive panel that activates only when pre-set game conditions are met, as determined by the Game Server. These conditions may include specific game outcomes, time-based triggers, or reaching certain wagering thresholds.

When conditions are met, the dealer's interface illuminates, prompting the dealer to activate the multiplier feature. Upon activation, the RNG selects a multiplier value from a predefined range (e.g., 2× to 10×). The selected multiplier is then transmitted to the Jackpot Control System, which calculates the new potential jackpot amount. This information is instantly relayed to all connected ETGTs and the Jackpot Display System.

The implementation leverages the existing network infrastructure of the casino but introduces new data pathways specifically for multiplier activation and jackpot updates. This ensures that the feature may be seamlessly integrated into existing DETG setups without requiring substantial hardware modifications. The system also includes fail-safes to prevent accidental or unauthorized multiplier activations, such as requiring dealer authentication or management approval for multipliers above a certain threshold.

Example Walk-through Scenario: At a busy casino, six players are engaged in a live baccarat game on a DETG system. The current mystery jackpot stands at $10,000. As the game progresses, the dealer notices that a pre-set condition has been met—in this case, five consecutive Banker wins. The Live Dealer Interface alerts the dealer that they may now activate the jackpot multiplier.

The dealer dramatically announces to the players that a special event is occurring and touches the multiplier activation button on their interface. The large Jackpot Display System shows an animation of a spinning wheel, building anticipation. The wheel stops, revealing a 5× multiplier. The display updates to show the new potential jackpot of $50,000.

Players react with excitement, and those who haven't placed side bets for jackpot eligibility rush to do so for the next round. The dealer explains that for the next three rounds, any jackpot win will be subject to this multiplier. Player A, who has been consistently placing jackpot side bets, feels a surge of anticipation.

In the second round of the multiplier period, Player A's hand qualifies for the mystery jackpot. The Jackpot Control System verifies eligibility, applies the 5× multiplier, and Player A is awarded $50,000 instead of the original $10,000. The Casino Management System records this win, updates Player A's tracking information, and resets the jackpot for the next game.

Player Interaction: Players interact with this feature primarily through their individual ETGTs. When the dealer activates the multiplier, each ETGT displays a notification and updates the potential jackpot amount. Players may view their eligibility status and, if not already participating, are prompted with an option to place a side bet for jackpot eligibility.

The ETGTs also display a countdown timer for the duration of the multiplier effect, creating a sense of urgency and excitement. Players may track their potential winnings in real-time, seeing how the multiplier affects various jackpot tiers or mystery jackpot amounts.

For players using the casino's mobile app, push notifications may be sent when a multiplier is activated at their table, encouraging them to return to the game if they've stepped away. The app also allows players to view multiplier history and statistics, adding a layer of strategy to their gaming experience.

Distinguishing Innovative Concepts: This dealer-chosen jackpot multiplier concept introduces several novel elements to DETG systems:
1. Dealer Engagement: Unlike traditional automated jackpot systems, this concept actively involves the dealer in the jackpot process, creating a unique blend of electronic and human-driven excitement.
2. Dynamic Jackpot Sizing: The multiplier allows for sudden, dramatic increases in jackpot size without requiring extended periods of accumulation, differentiating it from standard progressive jackpots.
3. Time-Limited Opportunity: The multiplier's effect for a set number of rounds creates a “jackpot within a jackpot” scenario, intensifying player engagement for a specific duration.
4. Condition-Based Activation: Tying the multiplier availability to specific game conditions adds a layer of anticipation and reward for observant players.
5. Multi-Player Impact: The multiplier affects all eligible players, fostering a sense of shared excitement and community among DETG participants.

These concepts collectively transform the DETG experience from a purely individual pursuit to a more dynamic, community-oriented game where the actions of the dealer and the flow of the game directly impact potential rewards.

### Distinguishing Inventive Steps:

1. Conditional Multiplier Activation: The system continuously monitors game outcomes and player behaviors. When preset conditions are met, it signals the Live Dealer Interface to enable the multiplier option. This step is unique in that it creates a bridge between game events and jackpot opportunities, something not typically seen in traditional ETGTs or EGMs.
2. Dealer-Initiated Random Selection: Upon dealer activation, the system engages a specialized RNG process to select the multiplier value. This step combines the unpredictability of RNG with the human element of dealer interaction, creating a novel hybrid between electronic and live dealer games.
3. Real-Time Jackpot Recalculation and Distribution: Once the multiplier is applied, the Jackpot Control System instantaneously recalculates potential jackpot amounts for all tiers and distributes this information across the network to all connected devices. This step ensures that all players have immediate, accurate information about their potential winnings, enhancing transparency and excitement in a way unique to this DETG implementation.

These steps collectively enable a more interactive and dynamic jackpot experience that goes beyond the capabilities of conventional ETGTs and EGMs. They create a system where the jackpot itself becomes an active, evolving element of the game, influenced by both electronic systems and human factors.

35 USC 101 Considerations: The dealer-chosen jackpot multiplier concept presents a strong case for patentability under 35 USC 101 by demonstrating a clear improvement to computer functionality and solving a problem in an existing technological process.

Firstly, this concept goes beyond a mere abstract idea by implementing a specific, novel interaction between electronic systems and human input in a gaming context. It's not simply applying a known process to a computer environment but creating a new form of jackpot management that couldn't exist without the unique integration of ETGTs, dealer interfaces, and backend systems.

Secondly, the invention addresses a specific problem in DETG technology: the lack of dynamic, engaging jackpot systems that may adapt in real-time to game conditions and dealer input. By solving this, it directly improves the functionality of DETG systems, enhancing their capability to provide more exciting and varied gaming experiences.

The concept integrates this improvement into a practical application by providing a concrete implementation that enhances the overall DETG ecosystem. It doesn't merely use computers as tools but fundamentally alters how jackpots are managed and awarded in a networked gaming environment.

Furthermore, the invention results in a discernible advancement in computer functionality within the gaming industry. It enables ETGTs to process and respond to a new type of input (dealer-activated multipliers based on game conditions), requiring novel data processing pathways and real-time system adjustments that weren't previously necessary or possible in traditional ETGT setups.

In summary, this innovative concept represents a technological solution to a problem specific to computerized gaming systems, implementing an unconventional step (dealer-chosen multipliers) to improve an existing technological process (jackpot management in ETGTs). This aligns strongly with the criteria for patentable subject matter under 35 USC 101.

Data Input: For this innovative concept, data inputs come from multiple sources:
1. Player Inputs: Each player provides input through their ETGT, including placing bets, opting into jackpot eligibility, and potentially selecting preferences for jackpot notifications.
2. Dealer Inputs: The live dealer provides notable input through the Live Dealer Interface, primarily the activation of the jackpot multiplier when conditions are met.
3. Game Outcome Data: The Game Server continuously inputs data about game outcomes, which is used to determine when multiplier activation conditions are met.
4. Player Tracking System: Inputs player history and current session data to determine jackpot eligibility and personalize the experience.
5. Casino Management System: Provides input on overall jackpot parameters, including multiplier ranges and activation conditions.

This multi-source input system is novel for DETGs as it combines automated data collection with real-time human input from both players and dealers, creating a more dynamic and responsive jackpot system than conventional ETGTs or EGMs.

### Component Interactions and Procedural Steps:

1. Game Initiation: The ETGT communicates with the Game Server to start a new round, while simultaneously checking player jackpot eligibility with the Player Tracking System.
2. Condition Monitoring: Throughout gameplay, the Game Server monitors outcomes, comparing them against preset conditions for multiplier activation.
3. Multiplier Activation Alert: When conditions are met, the Game Server signals the Live Dealer Interface, illuminating the multiplier activation option.
4. Dealer Action: The dealer chooses to activate the multiplier through their interface, sending a signal to the Jackpot Control System.
5. Multiplier Selection: The Jackpot Control System engages the RNG to select a multiplier value, then calculates new potential jackpot amounts.
6. Information Distribution: Updated jackpot information is sent to all ETGTs, the Jackpot Display System, and the Casino Management System.
7. Player Notification: ETGTs display the new jackpot amounts and any changes to player eligibility.
8. Jackpot Monitoring: During the multiplier period, the Jackpot Control System closely monitors all games for potential wins.
9. Win Processing: If a jackpot is won, the Jackpot Control System calculates the final amount, communicates with the Casino Management System for payout authorization, and signals the winning ETGT.
10. Reset and Reporting: After a win or at the end of the multiplier period, the system resets, and comprehensive data is sent to the Casino Management System for analysis and reporting.

This process uniquely integrates human decision-making (dealer activation) with automated systems in a way not seen in traditional ETGTs or EGMs, creating a more engaging and dynamic jackpot experience.

Data Processing: The Jackpot Control System processes data in several notable ways:
1. Eligibility Calculation: It continuously processes player bet data to determine jackpot eligibility.
2. Multiplier Application: When activated, it applies the RNG-selected multiplier to all relevant jackpot tiers.
3. Win Probability Adjustment: The system may adjust win probabilities based on the current multiplier to maintain overall payout ratios.
4. Real-Time Jackpot Updates: It constantly recalculates and updates potential jackpot amounts based on incoming bets and active multipliers.
5. Win Verification: Upon a potential win, it rapidly verifies eligibility, calculates the final payout amount, and initiates the payout process.

This processing is unique to this DETG implementation as it must handle sudden, significant changes to jackpot amounts and win conditions in real-time, something not typically required in traditional jackpot systems.

Outputs and Responses: The system provides various outputs:
1. ETGT Displays: Each terminal shows current jackpot amounts, multiplier status, and personalized eligibility information.
2. Jackpot Display System: Large screens show dramatic visualizations of multiplier activations and current jackpot amounts.
3. Dealer Interface: Provides feedback on multiplier activation and current game state.
4. Casino Management System: Receives comprehensive reports on jackpot performance, player engagement, and financial impacts.
5. Player Mobile Apps: May receive push notifications about multiplier activations and jackpot status changes.

These outputs are distinguished by their real-time nature and the integration of both individual (per-ETGT) and communal (large displays) information channels, enhancing the social aspect of DETG play.

Data Storage and Reporting: The system stores various data types:
1. Jackpot History: Records of all jackpot amounts, multipliers applied, and wins.
2. Player Participation: Detailed logs of player jackpot eligibility and betting patterns.
3. Dealer Activations: Timestamps and frequencies of multiplier activations.
4. Game Condition Triggers: Records of which game conditions led to multiplier availability.

This data is used to generate reports on jackpot performance, player engagement trends, and the effectiveness of different multiplier activation conditions. The unique aspect here is the inclusion of dealer-driven events in jackpot data analysis, providing insights not available in fully automated systems.

Error Handling and Security Measures: The system includes several security features:
1. Multiplier Activation Verification: May require secondary confirmation for large multipliers to prevent accidental activation.
2. Jackpot Calculation Redundancy: Uses multiple servers to verify jackpot amounts, preventing errors or manipulation.
3. Encrypted Communication: All data between components is encrypted to prevent tampering.
4. Audit Logging: Comprehensive logs of all system actions for regulatory compliance and dispute resolution.

These measures are tailored to the unique challenges of a dealer-influenced jackpot system, addressing both electronic and human-factor security concerns.

End of Interaction: At the conclusion of a jackpot event or gaming session:
1. The system resets multipliers to their default state.
2. Final session data is transmitted to the Casino Management System.
3. ETGTs display summary information to players, including their jackpot participation and near-misses.
4. The Jackpot Control System prepares for the next gaming session, potentially adjusting parameters based on recent performance.

This end-of-interaction process is unique in its comprehensive data collation and preparation for continuous play, reflecting the ongoing nature of DETG operations as compared to traditional slot machines or table games.

### Innovative Concept 37—Progressive Jackpots for Side Games

Identification of Concept: This innovative concept introduces a multi-layered jackpot system for Dealer-controlled Electronic Table Games (DETGs) where players may participate in smaller side games during the main game, with winnings from these side games contributing to a progressive mystery jackpot pool. This feature adds depth and excitement to the DETG experience by offering players additional ways to engage and win while simultaneously building a larger, more enticing jackpot. The side games are designed to be quick, simple, and thematically related to the main game, ensuring they don't detract from the primary gameplay but rather enhance the overall experience.

### Sequence Diagram Components:

1. Electronic Table Game Terminal (ETGT): The primary interface for players, displaying the main game, side games, and jackpot information.
2. Player A, Player B: Individual players participating in both the main game and side games.
3. Live Dealer Interface: A specialized terminal used by the dealer to manage the main game and trigger side game rounds.
4. Side Game Module: A software component that manages the logic and outcomes of the side games.
5. Progressive Jackpot Controller: Manages the accumulation and distribution of the progressive jackpot.
6. Main Game Server: Oversees the primary game logic and communicates with all ETGTs.
7. Random Number Generator (RNG): Ensures fairness in both main and side games.
8. Player Tracking System: Monitors player activity across main and side games.
9. Jackpot Display System: Shows current jackpot amounts and recent side game winners.
10. Casino Management System: Oversees all gaming operations and financial transactions.

Implementation Details: The ETGT is enhanced with a dedicated section of the screen for side games, seamlessly integrated with the main game display. This side game area is designed to be non-intrusive yet easily accessible, allowing players to participate without losing focus on the primary game. The Side Game Module is a new software component that interfaces with the Main Game Server and the Progressive Jackpot Controller. It manages multiple side games, each with unique rules and contribution rates to the jackpot.

The Live Dealer Interface is upgraded to include controls for initiating side game rounds, which may be tied to specific events in the main game or occur at regular intervals. This integration allows the dealer to maintain control over the pace and flow of both the main game and side games.

The Progressive Jackpot Controller is configured to handle multiple contribution streams—from the main game bets and from each type of side game. It dynamically adjusts the jackpot growth rate based on overall participation levels and uses a sophisticated algorithm to ensure fair distribution of the jackpot across different buy—in levels.

A notable innovation is the implementation of a “jackpot contribution visualizer” on each ETGT, showing players in real-time how their side game play is impacting the overall jackpot size. This feature leverages advanced graphics rendering to create an engaging, animated representation of jackpot growth.

Example Walk-through Scenario: At a busy casino, eight players are engaged in a live baccarat game on a DETG system. The current progressive mystery jackpot stands at $50,000. As the dealer prepares to deal the next hand, they announce the start of a side game round.

The side game for this round is a quick “High Card Draw” where players may bet on drawing a higher card than the dealer. Players have 15 seconds to opt-in and place their side bets. Player A and Player B both decide to participate, placing $10 side bets.

As the main baccarat hand is dealt, the Side Game Module simultaneously conducts the High Card Draw. Player A wins their side game, doubling their $10 bet. Player B loses their side bet. The Progressive Jackpot Controller calculates the contribution from this side game round—5% of all side game bets plus 2% of winnings. In this case, $1.10 is added to the jackpot pool.

The Jackpot Display System updates, showing the new jackpot amount of $50,001.10. Players' ETGTs display animations showing how their play contributed to the jackpot growth. Player A's screen shows a larger contribution due to their win.

As the session continues, various side games are offered between main game hands. Some players consistently participate, while others focus solely on the main game. After an hour of play, the jackpot has grown to $55,000 due to contributions from both main game and side game play.

Suddenly, during a side game of “Match the Dealer” (where players bet on receiving a card that matches the dealer's card), Player B hits a rare combination that triggers the mystery jackpot. The Progressive Jackpot Controller verifies the win, and Player B is awarded the full $55,000 jackpot. The Casino Management System records the win, updates Player B's tracking information, and resets the progressive jackpot for the next game cycle.

Player Interaction: Players interact with this feature primarily through their individual ETGTs. The side game area on the ETGT screen allows players to easily toggle between different available side games, place bets, and view outcomes. Players may set preferences for auto-participation in certain side games or receive alerts when specific side games become available.

The “jackpot contribution visualizer” provides real-time feedback on how each player's actions impact the jackpot. This may be represented as a personal “contribution meter” that fills up based on side game play, creating a sense of investment in the jackpot's growth.

Players may also access detailed statistics about their side game performance and jackpot contributions through a dedicated menu on their ETGT or via the casino's mobile app. This information may include win/loss ratios for each side game, total contributions to the jackpot, and personalized “lucky” side games based on past performance.

Distinguishing Innovative Concepts:
1. Multi-Stream Jackpot Contributions: This system uniquely combines contributions from both main game play and various side games, creating a more rapidly growing and engaging jackpot.
2. Dealer-Controlled Side Game Initiation: Unlike fully automated systems, this concept allows the live dealer to integrate side game rounds seamlessly into the flow of the main game, preserving the human element of live dealer games.
3. Dynamic Side Game Selection: The system may offer different side games based on the current state of the main game, time of day, or player preferences, creating a more personalized and varied gaming experience.
4. Real-Time Contribution Visualization: The innovative “jackpot contribution visualizer” provides immediate feedback to players, reinforcing the link between their play and jackpot growth.
5. Layered Engagement Model: By offering both main game and side game opportunities, this system caters to different player preferences and attention levels, potentially increasing overall player retention and engagement.

These concepts collectively transform the DETG experience from a single-focus game to a multi-faceted entertainment system where players may engage at various levels while all contributing to a shared goal.

### Distinguishing Inventive Steps:

1. Synchronized Side Game Integration: The system synchronizes the timing of side games with the main game flow, triggered by specific dealer actions or game states. This step creates a seamless blend of primary and secondary gameplay not typically seen in traditional ETGTs or EGMs.
2. Adaptive Jackpot Contribution Calculation: The Progressive Jackpot Controller employs an adaptive algorithm that adjusts contribution rates in real-time based on overall side game participation levels, main game bet volumes, and current jackpot size. This ensures balanced and engaging jackpot growth regardless of fluctuations in player activity.
3. Personalized Side Game Offering: Based on individual player history and preferences tracked by the Player Tracking System, the Side Game Module dynamically adjusts the types and frequency of side games offered to each player. This creates a tailored experience that maximizes engagement and jackpot contributions.

These steps collectively enable a more interactive and personalized jackpot experience that goes beyond the capabilities of conventional ETGTs and EGMs. They create a system where the jackpot growth is a direct result of diverse player actions across multiple game layers, fostering a stronger sense of player agency and community in the jackpot's evolution.

35 USC 101 Considerations: The progressive jackpots for side games concept presents a compelling case for patentability under 35 USC 101 by demonstrating a significant improvement to computer functionality and addressing a specific problem in DETG technology.

This concept transcends a mere abstract idea by implementing a complex, multi-layered system of game interactions and jackpot contributions that may only exist within a sophisticated computerized gaming environment.

It's not simply applying known jackpot principles to a new context, but creating an entirely new ecosystem of interconnected gameplay and reward mechanisms.

The invention solves a specific technological problem in DETG systems: the challenge of maintaining player engagement and creating communal excitement in a digitally mediated environment. By introducing a system that allows for simultaneous participation in main and side games, all contributing to a shared jackpot, it directly enhances the functionality and appeal of DETG platforms.

This improvement is integrated into a practical application through a concrete implementation that fundamentally alters how jackpots are accumulated and how players interact with both the game and each other in a DETG setting. The system may require novel data processing pathways to handle the real-time integration of multiple game outcomes, player inputs, and jackpot calculations.

The invention results in a discernible advancement in computer functionality within the gaming industry. It enables ETGTs to process and respond to a much more complex set of inputs and game states, requiring sophisticated algorithms to manage side game selection, jackpot contributions, and personalized player experiences. This level of real-time, multi-faceted gameplay management represents a significant leap beyond the capabilities of traditional ETGT setups.

Furthermore, the concept introduces a new type of player interaction with the gaming system through the “jackpot contribution visualizer,” which may require innovative graphics rendering and data representation techniques. This feature not only enhances the user experience but also necessitates advancements in how gaming data is processed and displayed in real-time.

In summary, this innovative concept represents a technological solution to multiple challenges specific to computerized gaming systems. It implements an unconventional and complex system of interwoven gameplay elements to improve upon existing ETGT technology, aligning strongly with the criteria for patentable subject matter under 35 USC 101.

Data Input: The system processes various types of data inputs:
1. Player Inputs: Main game bets, side game selections, and bet amounts entered through the ETGT interface.
2. Dealer Inputs: Commands to initiate side games and progress the main game, entered through the Live Dealer Interface.
3. Game Outcome Data: Results from both the main game and side games, generated by the Main Game Server and Side Game Module respectively.
4. Player Tracking Data: Historical player behavior and preferences, used to personalize side game offerings.
5. Temporal Data: Time of day and duration of play sessions, influencing side game availability and jackpot growth rates.
6. Jackpot Status Data: Current jackpot amount and growth rate, used to adjust contribution calculations.

This multi-faceted input system is novel for DETGs as it processes a much wider range of data types simultaneously, creating a more dynamic and responsive gaming environment than conventional systems.

### Component Interactions and Procedural Steps:

1. Game Initiation: The Main Game Server signals the start of a new main game round to all ETGTs and the Live Dealer Interface.
2. Side Game Availability Check: The Side Game Module queries the current game state, time, and player preferences to determine which side games to offer.
3. Dealer Side Game Activation: The dealer uses the Live Dealer Interface to initiate a side game round, sending a signal to the Side Game Module.
4. Player Side Game Participation: ETGTs display available side games and accept player bets, transmitting this data to the Side Game Module.
5. Simultaneous Game Resolution: As the main game progresses, the Side Game Module resolves side game outcomes using the RNG.
6. Jackpot Contribution Calculation: The Progressive Jackpot Controller calculates contributions from both main and side game play.
7. Real-Time Display Updates: The Jackpot Display System and individual ETGTs update to show new jackpot amounts and personal contributions.
8. Player Tracking Update: The Player Tracking System records all main and side game activity for each player.
9. Jackpot Win Check: After each game round, the Progressive Jackpot Controller checks for jackpot trigger conditions across all games.
10. Payout Processing: In the event of a jackpot win, the Casino Management System is notified to process the payout and reset the jackpot.

This process uniquely integrates multiple game layers and player interactions in real-time, creating a more complex and engaging ecosystem than traditional ETGT or EGM systems.

Data Processing: The system performs several notable data processing functions:
1. Multi-Game Outcome Processing: Simultaneously handling results from the main game and multiple side games.
2. Dynamic Jackpot Contribution Calculation: Adjusting contribution rates based on current game states, participation levels, and jackpot size.
3. Personalization Algorithm: Processing player history and preferences to tailor side game offerings.
4. Real-Time Visualization Computation: Calculating and rendering individual player contributions to the jackpot.
5. Predictive Analysis: Using current play patterns to adjust side game offerings and jackpot growth rates for maximum engagement.

This level of complex, real-time data processing distinguishes the system from traditional jackpot implementations, enabling a more dynamic and personalized gaming experience.

Outputs and Responses: The system generates various outputs:
1. ETGT Displays: Show main game state, available side games, individual game outcomes, and personalized jackpot contribution visualizations.
2. Jackpot Display System: Presents current jackpot amounts, recent side game winners, and overall contribution rates.
3. Dealer Interface: Provides options for side game initiation and displays overall game state information.
4. Casino Management System: Receives comprehensive reports on game performance, jackpot statistics, and player engagement metrics.
5. Player Mobile Apps: May display personalized side game statistics, jackpot contribution history, and alerts for favorite side games.

These outputs are distinguished by their highly personalized nature and the integration of multi-game layer information, providing a richer, more engaging player experience than traditional systems.

Data Storage and Reporting: The system stores and reports on various data types:
1. Game History: Detailed logs of all main and side game outcomes.
2. Player Activity: Comprehensive records of each player's main game and side game participation, including betting patterns and preferences.
3. Jackpot Progression: Timestamped records of jackpot growth, including contribution sources and rates.
4. Side Game Performance Metrics: Analytics on the popularity and profitability of different side games.

This data is used to generate in-depth reports on overall game performance, player engagement trends, and the effectiveness of different side game and jackpot configurations. The unique aspect here is the multi-dimensional nature of the data, providing insights into player behavior across different game layers and their collective impact on jackpot progression.

Error Handling and Security Measures: The system implements robust error handling and security:
1. Cross-Verification: Main and side game outcomes are verified across multiple system components to prevent errors or manipulation.
2. Contribution Audit Trail: Detailed logging of all jackpot contributions for regulatory compliance and dispute resolution.
3. Encrypted Multi-Channel Communication: All data exchanged between system components is encrypted, with separate channels for game outcomes, player data, and jackpot information.
4. Adaptive Fraud Detection: The system uses machine learning algorithms to detect unusual patterns in side game play or jackpot contributions that may indicate attempted fraud.

These measures are tailored to the unique challenges of a multi-layered game system, addressing security concerns across multiple game types and contribution streams.

End of Interaction: At the conclusion of a gaming session:
1. The system compiles comprehensive play history for each player, including main game and side game performance.
2. Final jackpot contribution data is calculated and added to each player's profile.
3. ETGTs display session summaries, including total contributions to the jackpot and any milestone achievements in side game play.
4. The Side Game Module and Progressive Jackpot Controller analyze session data to optimize game offerings and contribution rates for future sessions.

This end-of-interaction process is unique in its holistic approach, consolidating data from multiple game layers to provide players with a comprehensive view of their gaming experience and its impact on the broader jackpot ecosystem.

### Innovative Concept 38—Player-Specific Jackpot Odds Adjustments

Identification of Concept: This innovative concept involves a dynamic system for adjusting the odds of winning a mystery jackpot based on a player's historical data and engagement across various games within the casino ecosystem. The system is designed to be implemented in live dealer electronic game table systems and Dealer-controlled Electronic Table Games (DETGs), comprising multiple Electronic Table Game Terminals (ETGTs). This concept goes beyond traditional fixed-odds jackpot systems by creating a personalized jackpot experience for each player. The system analyzes various factors such as a player's betting patterns, frequency of play, game preferences, and overall casino engagement to dynamically adjust their odds of winning the mystery jackpot. This approach not only incentivizes continued play and exploration of different games but also creates a more engaging and tailored gaming experience for each individual player.

### Sequence Diagram Components:

1. Electronic Table Game Terminal (ETGT): The primary interface for players, equipped with touchscreens, card readers, and communication modules.
2. Player A and Player B: Individual players interacting with the ETGTs.
3. Live Dealer: The human dealer managing the physical game elements and interacting with players through video streaming.
4. Player Tracking System: A centralized system that collects and stores player data across all casino games and interactions.
5. Jackpot Odds Adjustment Engine: A specialized software component that processes player data and calculates personalized jackpot odds.
6. Mystery Jackpot Controller: Manages the overall jackpot system, including triggering wins and managing the prize pool.
7. Game Server: Coordinates game logic and communicates between ETGTs and other system components.
8. Casino Management System: Oversees all casino operations and integrates various subsystems.
9. Data Analytics Engine: Processes large volumes of player data to identify patterns and inform the odds adjustment algorithm.
10. Video Streaming Server: Manages the live video feed from the dealer to the ETGTs.

Implementation Details: The Player-Specific Jackpot Odds Adjustments system is implemented through a sophisticated integration of hardware and software components within the DETG ecosystem. Each ETGT is equipped with a high-resolution touchscreen interface that not only displays the live game feed but also provides real-time information about the player's personalized jackpot odds. A secure card reader integrated into the ETGT allows players to log in to their casino accounts, enabling the system to track their play across multiple sessions and games.

The specific of this system is the Jackpot Odds Adjustment Engine, a specialized software component that runs on dedicated servers within the casino's secure network. This engine continuously processes data from the Player Tracking System, which collects information from all of the player's interactions across the casino, including slot machines, traditional table games, and other DETGs. The engine employs advanced machine learning algorithms to analyze this data and calculate personalized jackpot odds for each player.

To enable real-time odds adjustments, the ETGTs are connected to the central Game Server via a high-speed, low-latency network. This server acts as the intermediary between the ETGTs, the Jackpot Odds Adjustment Engine, and the Mystery Jackpot Controller. When a player initiates a game session, the Game Server requests updated odds from the Jackpot Odds Adjustment Engine and communicates these to the ETGT.

The Mystery Jackpot Controller, another notable component, manages the overall jackpot system. It determines when a jackpot is triggered based on the adjusted odds for each player, ensuring fair and random distribution of wins while adhering to the personalized odds structure. This controller also manages the jackpot prize pool, which may be funded through a combination of player side bets and casino contributions.

To enhance the live dealer experience, a high-quality video streaming system is implemented. The Video Streaming Server compresses and transmits the live feed from the dealer's table to each ETGT with minimal latency, ensuring a seamless integration of the physical and digital aspects of the game.

Example Walk-through Scenario: Let's consider a scenario with two players, Alice and Bob, playing at separate ETGTs in a live dealer blackjack game with the Player-Specific Jackpot Odds Adjustments feature.
1. Alice and Bob each insert their player cards into their respective ETGTs and log in to their accounts.
2. The Player Tracking System retrieves their historical data and sends it to the Jackpot Odds Adjustment Engine.
3. The engine analyzes the data: Alice has been a frequent player across various games, while Bob is relatively new to the casino.
4. The Jackpot Odds Adjustment Engine calculates personalized odds: Alice's odds of winning the mystery jackpot are set at 1 in 10,000, while Bob's are 1 in 15,000.
5. As the blackjack game begins, both players see their personalized jackpot odds displayed on their ETGT screens.
6. During play, Alice makes consistent bets and occasionally tries side bets. The system records this behavior, gradually improving her odds to 1 in 9,500.
7. Bob, playing conservatively, sees his odds remain stable.
8. Midway through the session, Alice receives a notification that her odds have improved due to her consistent play.
9. Near the end of their session, the Mystery Jackpot Controller determines that a jackpot will be awarded.
10. Based on the adjusted odds, Alice has a higher chance of winning. The system randomly selects a winner, and Alice's ETGT displays a jackpot win celebration.
11. The dealer is notified of the win through their interface and congratulates Alice.
12. The jackpot amount is credited to Alice's account, and both players' odds are reset for their next session.

This scenario demonstrates how the system creates a dynamic and personalized experience, encouraging continued play and engagement with the casino's various offerings.

Player Interaction: Players interact with the Player-Specific Jackpot Odds Adjustments system primarily through their assigned ETGTs. Upon approaching an ETGT, a player inserts their casino loyalty card or enters their unique identifier. The ETGT's touchscreen interface then displays a personalized welcome message along with their current jackpot odds.

As the player engages in the live dealer game, they may view their real-time jackpot odds displayed in a non-intrusive corner of the screen. The interface may include a graphical representation, such as a dynamic bar or meter, showing how close they are to potentially improving their odds. Players may access a detailed breakdown of factors influencing their odds through a dedicated menu option.

The system encourages exploration and varied gameplay by offering temporary odds boosts for trying new games or betting patterns. For example, if a player typically only plays blackjack, they may receive a notification suggesting, “Try our live dealer baccarat for a 10% jackpot odds boost for the next hour!”

Players may also interact with the system through strategic gameplay. For instance, maintaining a certain level of bets over time or participating in designated “jackpot boost” periods may positively influence their odds. The ETGT interface provides subtle cues and notifications to guide players towards actions that may improve their standing.

Moreover, the system allows for social interaction. Players may opt to display their jackpot odds ranking among current players at their table or across the casino floor, fostering a sense of friendly competition. Special multiplayer events may be organized where collaborative play across multiple ETGTs may trigger collective odds improvements.

### Distinguishing Innovative Concepts:

1. Dynamic Personalization: Unlike traditional fixed-odds jackpot systems, this concept creates a unique, evolving jackpot experience for each player based on their individual gaming history and current behavior.
2. Cross-Game Analysis: The system analyzes player data across multiple game types and platforms within the casino ecosystem, not just within a single game or table, to inform odds adjustments.
3. Real-Time Odds Calculation: The Jackpot Odds Adjustment Engine performs continuous, real-time calculations to update a player's odds, creating a highly responsive system that may adapt to changes in play style within a single session.
4. Integrated Incentive Structure: By tying jackpot odds to overall casino engagement, the system creates a powerful incentive for players to explore different games and maintain consistent play patterns.
5. Transparent Odds Display: Unlike many mystery jackpot systems where the odds are hidden, this concept provides players with clear visibility into their current standing and the factors influencing it.
6. Adaptive Learning Algorithm: The system employs machine learning techniques to continually refine its understanding of player behavior and optimize the odds adjustment parameters for maximum engagement.
7. Multi-Table Synchronization: The system may synchronize jackpot odds and potential wins across multiple DETGs, creating a cohesive experience as players move between tables or game types.

These concepts distinguish the system from conventional ETGTs and EGMs by creating a deeply personalized, dynamic, and transparent jackpot experience that spans the entire casino ecosystem.

### Distinguishing Inventive Steps:

1. Player Data Aggregation and Analysis: The system continuously collects and analyzes player data from multiple sources (ETGTs, traditional slots, table games) to create a comprehensive player profile. This goes beyond simple win/loss tracking to include detailed behavioral analysis.
2. Dynamic Odds Recalculation: The Jackpot Odds Adjustment Engine employs a proprietary algorithm to recalculate player-specific jackpot odds in real-time based on current play patterns and historical data. This algorithm considers factors such as bet size, frequency, game type, and overall casino engagement.
3. Personalized Incentive Generation: Based on the analyzed data and calculated odds, the system generates tailored incentives for each player. These may include temporary odds boosts for trying new games, loyalty rewards for consistent play, or special challenges to improve odds.

These steps are unique to supporting live dealer electronic game table systems and DETGs as they create a bridge between the personalized, data-driven approach of modern gaming machines and the social, high-engagement nature of live dealer games. This approach is distinctly different from conventional EGMs/platforms, which typically offer static jackpot odds or simplistic progressive systems that don't account for individual player behavior across multiple game types.

35 USC 101 Considerations: The Player-Specific Jackpot Odds Adjustments system represents patentable subject matter under 35 USC 101 for several compelling reasons:
(a) The innovative concept goes beyond a mere abstract idea by implementing a specific technological improvement in the field of electronic gaming systems. It captures a concrete methodology for dynamically adjusting jackpot odds based on comprehensive player data analysis, which is a tangible enhancement to existing gaming platforms.
(b) This concept is directed to an improvement in computer functionality that solves a problem in the technological process of managing electronic gaming systems. Specifically, it addresses the challenge of creating personalized, engaging experiences in a live dealer electronic table game environment—a problem unique to this technological context.
(c) The invention integrates the improvement into a practical application by implementing a system that enhances the functionality of DETGs and casino management systems. It enables these systems to provide a more engaging, personalized gaming experience, which represents a clear advancement in computer functionality within the gaming industry.

The system's use of real-time data processing, machine learning algorithms for odds adjustment, and integration with various casino systems demonstrates a sophisticated technological solution that goes well beyond merely implementing an abstract idea on a computer. The intricate interplay between hardware components (ETGTs, card readers) and software systems (Jackpot Odds Adjustment Engine, Player Tracking System) further underscores the technological nature of the invention.

Moreover, the invention addresses a specific challenge in the gaming industry—namely, how to create a more engaging and personalized jackpot experience in a live dealer electronic table game setting. This is not a longstanding human practice being merely computerized, but a novel solution to a problem arising in the realm of computer technology.

By providing a system that dynamically adjusts jackpot odds based on individual player behavior and history, the invention improves the technological field of electronic gaming. It enhances the functionality of DETGs and casino management systems in a way that was not previously possible, thereby satisfying the criteria for patent-eligible subject matter under 35 USC 101.

Data Input: The Player-Specific Jackpot Odds Adjustments system may require a diverse range of data inputs from multiple sources:
1. Player Identification Data: Unique identifiers from player loyalty cards or biometric inputs (e.g., facial recognition) to accurately track individual players across multiple sessions and games.
2. Game Play Data: Detailed information about each player's gaming activities, including:
   Bet amounts and patterns
   Game types and preferences
   Session duration and frequency
   Win/loss records
3. ETGT Interaction Data: How players interact with the ETGT interface, including:
   Menu navigation patterns
   Response to notifications and promotions
   Use of additional features (e.g., side bets, game statistics)
4. Cross-Platform Activity: Data from other casino systems, such as:
   Slot machine play
   Traditional table game participation
   Use of casino amenities (restaurants, hotels)
5. Temporal Data: Time-stamped information to analyze patterns in play behavior:
   Time of day preferences
   Day of week trends
   Seasonal variations
6. Dealer Input: In some cases, live dealers may input additional data:
   Player behavior observations
   Table atmosphere and energy levels
7. External Data Sources: With player consent, the system may incorporate data from:
   Social media activity related to casino experiences
   Online gaming behavior on casino-affiliated platforms

This comprehensive data collection enables the system to create a holistic view of each player's behavior and preferences, allowing for truly personalized jackpot odds adjustments. The novel aspect of this data input lies in its breadth and integration, combining traditional gaming metrics with behavioral and contextual data to create a more nuanced understanding of player engagement.

Component Interactions and Procedural Steps: The Player-Specific Jackpot Odds Adjustments system involves complex interactions between various components of the DETG and casino network. Here's a detailed breakdown of the process:
1. Player Login:
   Player inserts loyalty card or provides biometric data at ETGT
   ETGT sends login request to Player Tracking System
   Player Tracking System authenticates player and retrieves profile
2. Initial Odds Calculation:
   Player Tracking System sends player history to Jackpot Odds Adjustment Engine
   Engine analyzes data using machine learning algorithms
   Initial personalized odds are calculated and sent to Mystery Jackpot Controller
3. Game Initiation:
   Player selects game type on ETGT
   ETGT communicates with Game Server to start session
   Game Server requests current odds from Mystery Jackpot Controller
   Odds are displayed on ETGT screen
4. Live Gameplay:
   Video Streaming Server sends live dealer feed to ETGT
   Player interacts with game via ETGT touchscreen
   ETGT sends player actions to Game Server
   Game Server manages game logic and communicates results
5. Real-time Data Collection:
   ETGT continuously sends player behavior data to Player Tracking System
   Data Analytics Engine processes this information in real-time
6. Dynamic Odds Adjustment:
   Jackpot Odds Adjustment Engine receives updates from Data Analytics Engine
   Engine recalculates odds based on current behavior and historical data
   Updated odds are sent to Mystery Jackpot Controller and ETGT
7. Player Notification:
   ETGT displays odds changes and potential jackpot amounts
   System may trigger notifications for odds-boosting opportunities
8. Jackpot Trigger Evaluation:
   Mystery Jackpot Controller continuously evaluates win conditions
   When triggered, controller selects winner based on current odds
   Win signal sent to winning ETGT and Casino Management System
9. Jackpot Payout Process:
   Winning ETGT displays celebration animation
   Casino Management System verifies win and initiates payout
   Player's account is credited with winnings
10. Session End and Data Sync:
   Upon player logout, ETGT sends session summary to Player Tracking System
   Data Analytics Engine performs comprehensive analysis for future sessions

This process highlights the novel integration of real-time data analysis, machine learning, and multi-system communication to create a dynamic, personalized jackpot experience in a live dealer DETG environment.

Data Processing: The Player-Specific Jackpot Odds Adjustments system employs sophisticated data processing techniques to enable its dynamic functionality:
1. Data Aggregation: The system consolidates player data from multiple sources (ETGTs, slot machines, table games) into a unified player profile.
2. Pattern Recognition: Machine learning algorithms analyze player behavior to identify patterns in betting, game preferences, and overall casino engagement.
3. Predictive Modeling: The system uses historical data to predict future player behavior and potential responsiveness to odds adjustments.
4. Real-time Analysis: As players interact with ETGTs, the system continuously processes incoming data to update odds calculations.
5. Multi-factor Weighting: The odds adjustment algorithm weighs various factors (e.g., bet size, frequency of play, game variety) to determine appropriate odds.
6. Anomaly Detection: The system identifies unusual player behavior that may indicate changes in preferences or potential problematic gambling patterns.
7. Trend Analysis: Long-term data is processed to identify broader trends in player behavior and jackpot engagement across the casino.

The DETG system processes player-specific jackpot odds adjustments through a sophisticated algorithm that considers multiple factors. First, the system retrieves the player's historical data, including past gameplay, betting patterns, and jackpot participation across various game types. This data is analyzed to create a player profile that reflects their engagement level and loyalty.

The algorithm then applies a weighting system to different aspects of the player's history. For example, recent gameplay may be weighted more heavily than older data, and participation in specific high-value games may carry additional weight. The system also factors in the player's current session data, including time spent playing, amount wagered, and any notable wins or losses.

Based on these calculations, the system generates a personalized odds multiplier for the player. This multiplier is applied to the base jackpot odds, effectively increasing or decreasing the player's chances of triggering the mystery jackpot. The adjusted odds are then used in the random number generation process that determines jackpot triggers.

Importantly, the system continuously updates these odds in real-time as the player continues to engage with the DETG. This dynamic adjustment ensures that the odds accurately reflect the player's current status and recent activity, providing a highly personalized and engaging jackpot experience.

### Outputs and Responses:

The DETG system provides a range of outputs and responses related to the player-specific jackpot odds adjustments. Primarily, players receive real-time updates on their personalized jackpot odds through the DETG interface. This information is presented in an easily understandable format, such as “Your chances of winning the mystery jackpot are now 1.2× higher than the base odds!”

The system also generates visual cues to indicate when a player's odds have improved significantly. For example, the jackpot display on the DETG screen may flash or change color when the odds multiplier reaches certain thresholds. Additionally, the system sends personalized messages to encourage continued play, such as “Keep playing to further improve your jackpot odds!”

For players who opt-in, the system may send notifications to their mobile devices about their current jackpot odds status, even when they're not actively playing. This feature helps maintain engagement and may entice players back to the gaming floor.

The DETG also communicates with other casino systems to provide a holistic view of player activity. For instance, it sends data to the player tracking system to update loyalty points based on jackpot participation and adjusted odds. This integration ensures that players are rewarded for their engagement with the jackpot feature across multiple platforms.

### Data Storage and Reporting:

The DETG system stores comprehensive data related to player-specific jackpot odds adjustments in a secure, centralized database. This includes historical odds adjustments, factors contributing to each adjustment, and the resulting impact on jackpot wins. The system generates detailed reports for casino management, including trends in player engagement with the jackpot feature, the effectiveness of odds adjustments in driving player retention, and the overall impact on casino profitability. These reports are accessible through a secure management interface and may be customized to focus on specific time periods, player segments, or game types.

### Error Handling and Security Measures:

The DETG system incorporates robust error handling and security measures to ensure the integrity of the player-specific jackpot odds adjustments. It employs real-time data validation to detect and flag any anomalies in odds calculations or player data. If an error is detected, the system automatically reverts to default odds settings and alerts casino staff for immediate investigation. To prevent manipulation, all odds adjustments are logged with timestamps and operator IDs. The system also uses encryption for all data transmissions and implements strict access controls to prevent unauthorized modifications to the odds adjustment algorithm or player data.

### End of Interaction:

As a player concludes their gaming session, the DETG system performs a final update to their jackpot odds profile. It calculates the overall change in odds during the session and stores this information for future reference. The system then resets the player's active odds multiplier to a neutral state, ensuring a fresh start for their next session. Before the player leaves, the DETG displays a summary of their jackpot odds performance, including any notable improvements and how close they came to triggering the jackpot. This summary serves to reinforce the excitement of the feature and encourage future participation.

### Innovative Concept 39—Mobile Integration for Jackpot Alerts

Identification of Concept: This innovative concept introduces a mobile integration system for jackpot alerts in live dealer-controlled multiplayer games implemented at live dealer-streamed electronic game table systems and Dealer-controlled Electronic Table Games systems (DETGs). The system allows players to receive real-time alerts on their mobile devices when mystery jackpot windows or opportunities open. This feature enhances player engagement by providing timely notifications about potential jackpot wins, even when players are not actively at the gaming table. The mobile integration system works seamlessly with the DETG network, player tracking systems, and casino management systems to deliver personalized alerts based on player preferences, game types, and jackpot thresholds. This concept leverages the ubiquity of mobile devices to extend the excitement of live dealer games beyond the physical confines of the gaming floor, potentially increasing player participation and retention in jackpot-eligible games.

### Sequence Diagram Components:

1. Electronic Table Game Terminal (ETGT): The primary interface for players to participate in live dealer games and jackpot opportunities.
2. Player A: A player actively engaged in a live dealer game at an ETGT.
3. Player B: A player who is not currently at an ETGT but has opted for mobile alerts.
4. Mobile Device: The player's smartphone or tablet receiving jackpot alerts.
5. Casino Mobile App: The application installed on the player's device for receiving notifications.
6. DETG System: The central system managing multiple ETGTs and game logic.
7. Jackpot Management System: Responsible for tracking and triggering jackpots across the casino network.
8. Player Tracking System: Manages player accounts, preferences, and notification settings.
9. Mobile Alert Server: Handles the generation and distribution of mobile alerts to players.
10. Live Dealer: The human dealer managing the physical game components and interacting with players.
11. Casino Network: The underlying infrastructure connecting all components.

Implementation Details: To implement the mobile integration for jackpot alerts, each Electronic Table Game Terminal (ETGT) is equipped with a dedicated communication module that interfaces with the DETG System. This module continuously transmits game state information, including active players, bet amounts, and current jackpot status. The DETG System, in turn, communicates with the Jackpot Management System, which calculates the probability of jackpot triggers and determines when to open mystery jackpot windows.

The Player Tracking System maintains a database of player profiles, including their mobile notification preferences. Players may customize their alert settings through the ETGT interface or the Casino Mobile App, specifying thresholds for jackpot amounts, game types, and notification frequency.

When the Jackpot Management System detects an imminent jackpot opportunity, it signals the Mobile Alert Server. This server cross-references the jackpot data with player preferences stored in the Player Tracking System. It then generates personalized alert messages for eligible players.

The Mobile Alert Server utilizes push notification technology to send alerts through the Casino Mobile App. For players without the app installed, the system may fall back to SMS messaging, ensuring broad reach.

To maintain real-time responsiveness, the system employs a combination of websocket connections for active players and a polling mechanism for offline players. This hybrid approach optimizes network resources while ensuring timely delivery of alerts.

The implementation includes a secure API gateway that manages authentication and encryption of all data transmissions between the casino systems and players' mobile devices, ensuring compliance with gaming regulations and data protection laws.

Example Walk-through Scenario: Player A is actively playing at an ETGT, while Player B is away from the casino but has opted for mobile alerts. The live dealer initiates a new round of blackjack, and the ETGT communicates this to the DETG System.

As players place their bets, the Jackpot Management System calculates that a mystery jackpot window is about to open. It notifies the Mobile Alert Server, which queries the Player Tracking System for eligible players.

The system identifies that both Player A and Player B have opted for alerts for this game type and jackpot threshold. For Player A, the ETGT displays an on-screen notification about the jackpot opportunity. Simultaneously, the Mobile Alert Server sends a push notification to Player B's smartphone via the Casino Mobile App.

The notification reads: “Hot Jackpot Alert! A mystery jackpot between $5,000 and $10,000 may trigger in the next 15 minutes on Table 7. Tap to join the game remotely or reserve a seat!”

Player B, excited by the opportunity, uses the app to reserve a seat at the ETGT. The system acknowledges the reservation and starts a 10-minute countdown for Player B to arrive.

Meanwhile, Player A decides to increase their bet and activates the jackpot side bet option on the ETGT. The live dealer acknowledges new players joining and continues the game.

As the mystery jackpot window opens, both players receive real-time updates on their chances of winning, creating a heightened sense of anticipation and engagement throughout the game session.

Player Interaction: Players interact with the mobile jackpot alert system through multiple touchpoints. At the ETGT, players may access a settings menu to configure their mobile alert preferences, including jackpot thresholds, game types, and notification frequency. The Casino Mobile App provides a more comprehensive interface for managing these settings, allowing players to fine-tune their alert experience even when away from the gaming floor.

When receiving an alert, players may tap on the notification to open the app, which provides detailed information about the jackpot opportunity. From here, they may choose to join the game remotely, reserve a seat at the physical ETGT, or simply monitor the jackpot's progress.

For players already at an ETGT, the mobile integration allows them to receive alerts about jackpot opportunities at other tables, encouraging exploration of different games. The system also enables players to set reminders for upcoming jackpot events, fostering planned engagement with the casino's offerings.

Distinguishing Innovative Concepts: This mobile integration for jackpot alerts distinguishes itself from conventional ETGTs and EGMs in several notable ways. Firstly, it extends the gaming experience beyond the physical confines of the casino floor, creating a persistent connection between the player and the live dealer games. This continuous engagement is unique to this system and not typically found in traditional setups.

Secondly, the system's ability to personalize jackpot alerts based on individual player preferences and behaviors is a significant advancement. Unlike static jackpot displays on conventional machines, this system dynamically adjusts its communication based on each player's history, preferences, and current gaming context.

Thirdly, the integration of live dealer interactions with mobile technology creates a hybrid experience that bridges the gap between online and physical casino gaming. This synergy is particularly novel for DETG systems, as it combines the authenticity of live dealer games with the convenience and reach of mobile technology.

Furthermore, the system's capability to facilitate remote game joining and seat reservations in response to jackpot alerts is a unique feature that enhances the fluidity of the gaming experience. This level of responsive, opportunity-driven gameplay is not possible with traditional ETGTs or EGMs.

Lastly, the real-time nature of the alerts, coupled with the system's ability to calculate and communicate jackpot probabilities, introduces a new level of transparency and excitement to the jackpot experience. This real-time, data-driven approach to jackpot engagement is a distinguishing feature of this innovative concept.

### Distinguishing Inventive Steps:

1. Dynamic Jackpot Window Calculation: The system continuously analyzes game data across multiple ETGTs to determine optimal times for opening mystery jackpot windows. This step involves complex algorithms that consider factors such as player density, bet volumes, and historical jackpot patterns to maximize engagement and excitement.
2. Personalized Alert Generation: Unlike conventional systems that broadcast generic jackpot information, this system tailors alerts to individual players. It considers each player's gaming history, preferences, and current context to generate highly relevant and engaging notifications. This personalization extends to the timing, frequency, and content of the alerts.
3. Cross-Platform Synchronization: The system maintains seamless synchronization between the physical ETGT interfaces and the mobile app. This allows for real-time updates and interactions, such as remote game joining or seat reservations, which are triggered by mobile alerts. This synchronization is a novel step that bridges the gap between mobile and live dealer gaming experiences.

These steps are unique to supporting live dealer electronic game table systems and DETGs. They enable a level of player engagement and jackpot interaction that is not possible with conventional EGMs or platforms. The dynamic nature of the jackpot windows, coupled with personalized mobile alerts, creates a more exciting and responsive gaming environment. The cross-platform synchronization, in particular, represents a significant advancement in how players may interact with live dealer games, allowing for fluid transitions between mobile and physical gaming spaces.

35 USC 101 Considerations: The mobile integration for jackpot alerts system represents patentable subject matter under 35 USC 101 by providing a specific improvement over prior art systems, solving a problem in an existing technological process, and integrating the improvement into a practical application that enables a discernible advancement in computer functionality.

Firstly, this system goes beyond a mere abstract idea by implementing a concrete, technological solution to the problem of player engagement in live dealer electronic game table systems. It combines complex data analysis, real-time communication protocols, and personalized alert generation to create a novel gaming experience. This represents a specific improvement over prior art systems which typically lack such dynamic, player-centric jackpot notification capabilities.

Secondly, the invention addresses a problem in the existing technological process of casino gaming systems—namely, the disconnect between players and jackpot opportunities when they are not physically present at a gaming table. By leveraging mobile technology and advanced data processing, the system creates a persistent link between players and live games, solving this technological shortcoming.

Lastly, the invention integrates these improvements into a practical application that demonstrably advances computer functionality in the gaming industry. The system's ability to synchronize mobile devices with live dealer games, process complex player data in real-time, and facilitate seamless transitions between virtual and physical gaming spaces represents a significant technological advancement. This practical application goes beyond mere data processing, creating a new, more engaging form of casino gaming that was not previously possible.

Data Input: The mobile integration for jackpot alerts system may require various data inputs from multiple sources:
1. Player Input:
   Mobile alert preferences (jackpot thresholds, game types, notification frequency)
   App installation and login credentials
   Real-time responses to alerts (e.g., reserving seats, joining games)
2. ETGT Input:
   Current game state (active players, bet amounts, game type)
   Jackpot contribution amounts
   Player identification data
3. Jackpot Management System Input:
   Current jackpot amounts across all games
   Jackpot trigger probabilities
   Historical jackpot data
4. Player Tracking System Input:
   Player profiles and gaming histories
   Loyalty program status
   Customized alert settings
5. Live Dealer Input:
   Game pace and status updates
   Manual jackpot triggers or special event notifications

This diverse range of inputs enables the system to generate highly personalized and timely jackpot alerts, distinguishing it from conventional systems that rely on more limited data sources.

### Component Interactions and Procedural Steps:

1. Initialization:
   ETGTs connect to the DETG System, establishing secure communication channels.
   The Jackpot Management System initializes, loading current jackpot states and historical data.
   The Mobile Alert Server activates, ready to process and distribute notifications.
2. Player Registration:
   Players register for mobile alerts through the ETGT interface or Casino Mobile App.
   The Player Tracking System updates player profiles with alert preferences.
3. Continuous Monitoring:
   ETGTs transmit real-time game data to the DETG System.
   The Jackpot Management System analyzes this data to calculate jackpot probabilities and identify potential trigger windows.
4. Alert Generation:
   When a jackpot opportunity is identified, the Jackpot Management System signals the Mobile Alert Server.
   The Mobile Alert Server queries the Player Tracking System for eligible players based on preferences and game types.
   Personalized alert messages are generated for each eligible player.
5. Alert Distribution:
   The Mobile Alert Server sends push notifications to players' devices through the Casino Mobile App.
   For players at ETGTs, on-screen notifications are displayed via the DETG System.
6. Player Response:
   Players may interact with alerts, choosing to join games or reserve seats.
   These responses are communicated back through the Casino Mobile App or ETGT to the DETG System.
7. Game Integration:
   The DETG System updates game states based on player responses, potentially reserving seats or adding remote players.
   Live dealers are notified of incoming players or changes in game status.
8. Continuous Update:
   Throughout gameplay, the system continues to monitor jackpot status and player activity, generating new alerts as necessary.

This procedural flow highlights the novel, real-time interactions between multiple system components, enabling a dynamic and engaging jackpot alert experience unique to this DETG implementation.

Data Processing: The system processes data through several notable steps:
1. Jackpot Probability Calculation: The Jackpot Management System uses complex algorithms to analyze current game states, betting patterns, and historical data to calculate the probability of jackpot triggers.
2. Player Eligibility Determination: The system cross-references jackpot opportunities with player preferences and gaming histories stored in the Player Tracking System to determine alert eligibility.
3. Alert Personalization: For eligible players, the system generates personalized alert content based on individual preferences, current game context, and potential jackpot amounts.
4. Real-time Synchronization: The system continuously processes updates from ETGTs and player responses to alerts, ensuring that all components (mobile app, ETGTs, dealer interfaces) remain synchronized.
5. Predictive Analytics: The system may employ machine learning algorithms to predict player responsiveness to different types of alerts, optimizing future notification strategies.

This sophisticated data processing distinguishes the system from conventional ETGTs and EGMs, enabling highly targeted and effective jackpot engagement strategies.

Outputs and Responses: The system generates various outputs and responses:
1. Mobile Alerts: Personalized push notifications sent to players' mobile devices, containing jackpot information, probabilities, and call-to-action prompts.
2. ETGT Display Updates: Real-time updates on ETGTs showing current jackpot amounts, trigger probabilities, and alerts for active players.
3. Seat Reservation Confirmations: Automated responses to players who request seat reservations through mobile alerts, including countdown timers and directions to the specific ETGT.
4. Dealer Interface Updates: Notifications to live dealers about incoming players or changes in game status due to mobile alert interactions.
5. Jackpot Win Announcements: System-wide notifications when a jackpot is triggered, including winner information and updated jackpot reset amounts.
6. Player Analytics Reports: Detailed reports on alert effectiveness, player engagement rates, and jackpot participation trends.

These outputs and responses create a dynamic, interactive environment that significantly enhances the live dealer gaming experience compared to conventional systems.

Data Storage and Reporting: The system stores data across multiple secure databases:
1. Player Tracking Database: Stores player profiles, alert preferences, and interaction histories.
2. Jackpot History Database: Records all jackpot triggers, amounts, and associated game data.
3. Alert Analytics Database: Stores data on alert distributions, open rates, and resulting player actions.

The system generates comprehensive reports including:
Jackpot performance analytics
Player engagement metrics
Alert effectiveness statistics
Revenue impact assessments

These reports are accessible to casino management through a secure web portal, providing insights for optimizing jackpot strategies and player engagement.

Error Handling and Security Measures: The system implements robust error handling and security measures:
1. Redundant servers ensure continuous operation in case of hardware failures.
2. Encryption protocols secure all data transmissions between system components and player devices.
3. Multi-factor authentication is required for accessing sensitive system settings.
4. Automated error detection algorithms identify and flag unusual patterns in jackpot triggers or alert distributions.
5. Regular security audits and penetration testing ensure the system's integrity.
6. Compliance checks verify adherence to local gaming regulations and data protection laws.

End of Interaction: At the end of each gaming session or when a player opts out of alerts:
1. The system logs all player interactions and jackpot-related events.
2. Alert preferences are saved to the player's profile for future sessions.
3. Any active seat reservations or game joins are resolved or cancelled.
4. The Jackpot Management System recalculates probabilities based on the updated player pool.
5. The Mobile Alert Server stops sending notifications to the departing player.
6. The system resets for the next cycle of jackpot opportunities and player engagements.

### Innovative Concept 40—Time-Sensitive Jackpot Boosts

### Identification of Concept:

The Time-Sensitive Jackpot Boosts concept involves a jackpot system that increases player engagement by linking jackpot contributions to specific time intervals. During these intervals-such as casino-determined “Happy Hour” periods-players may contribute more to the jackpot, accelerating its growth. This concept is particularly appealing for live dealer-controlled multiplayer games and DETG systems in casinos where multiple players interact with Electronic Table Game Terminals (ETGTs). The mystery jackpot grows dynamically based on how many players place bets during the designated period, incentivizing participation at notable times.

In a live dealer-controlled environment, the dealer may manage the initiation and closing of time-sensitive jackpot windows. These windows may be dynamically announced, providing additional engagement for players as they race to place bets within the active interval. The boosted contributions during these windows may increase not only the jackpot's size but also the chances of a payout, further engaging the players and creating a sense of urgency. This feature may be integrated with other promotional activities in the casino, such as special jackpots or events.

### Sequence Diagram Components:

Electronic Table Game Terminal (ETGT): The primary interface through which players interact with the game. It registers bets, tracks player actions, and displays jackpot contribution details.
Live Dealer: Manages game flow, activates time-sensitive jackpot windows, and facilitates gameplay by interacting with both the players and the DETG system.
Casino Network: Facilitates communication between all ETGTs and backend systems, processes player data, and handles jackpot contribution calculations in real time.
Jackpot Server: Manages the jackpot pool, monitors contributions during the time-sensitive windows, and dynamically adjusts the jackpot size.
Player A, Player B: Multiple players interact with their respective ETGTs, place bets, and contribute to the jackpot. Each player's actions affect the total jackpot pool and chances of triggering a payout.

### Implementation Details:

To implement this concept, each ETGT may be configured to recognize time-sensitive jackpot windows. The terminals may be integrated with the casino network to dynamically adjust jackpot contributions based on the time intervals. The contribution rates for these windows may be set by the casino's backend systems, which may modify how much of a player's bet contributes to the jackpot based on the current time.

For example, during a Happy Hour window, the backend system may increase the percentage of each bet allocated to the jackpot. This system may also handle the communication between the ETGTs and the jackpot server to ensure real-time updates of jackpot values. Each terminal would have a clear visual indicator alerting players when a time-sensitive window is active, encouraging more frequent betting. The implementation also allows for synchronized contributions across multiple DETGs, so that regardless of the game being played, all contributions feed into a single, dynamically growing jackpot pool.

This differs from traditional ETGT implementations where contributions to jackpots are static or progressive based solely on the total bet amount. By introducing dynamic, time-sensitive windows, the implementation drives higher engagement and adds a layer of excitement that adapts to real-time casino floor activity.

### Example Walk-Through Scenario:

Imagine a scenario at a live dealer baccarat game using ETGTs. The dealer announces the start of a “Jackpot Boost” period that will last for 15 minutes. Player A and Player B, seated at their ETGTs, are notified on their screens about this opportunity. Both players place their bets for the next hand. During this time, the casino network dynamically increases the percentage of their bets contributing to the jackpot from 2% to 5%.

As Player A places a $100 bet, $5 is instantly allocated to the mystery jackpot pool. Player B places a smaller $50 bet, and $2.50 is added to the pool. The jackpot server processes these contributions in real time, increasing the jackpot value displayed across all active ETGTs. The system shows a countdown timer for the remaining “Jackpot Boost” window, creating urgency for other players to join in.

At the end of the period, the mystery jackpot size has increased significantly due to the boosted contributions. After several hands, a mystery jackpot event is triggered based on predefined game outcomes, and Player A wins the accumulated jackpot, further enhancing the excitement of the session.

### Player Interaction:

Players are notified through their ETGTs when a time-sensitive jackpot boost window becomes active. This creates a race against time, encouraging players to place more bets to maximize their contributions to the mystery jackpot. Visual and auditory cues, such as flashing displays or countdown timers, are employed to capture player attention. The dynamic increase in contributions is also displayed in real-time, showing how much each player's bets are affecting the jackpot.

Compared to traditional EGMs or ETGTs where contributions are passive and unaffected by time, this system adds an interactive layer, requiring players to act within a specific window to maximize their participation. This fosters competition and urgency, especially when players see the jackpot rapidly increasing during these windows.

### Distinguishing Innovative Concepts:

The notable innovation in this concept is the dynamic adjustment of jackpot contributions based on specific time windows. Unlike traditional mystery jackpots, which are either random or based on fixed contribution rates, the Time-Sensitive Jackpot Boosts concept incentivizes player behavior by providing clear and limited opportunities for increased contributions. The synchronization of multiple DETGs into a single jackpot pool adds to the scale and excitement.

This implementation is novel because it combines live dealer-controlled gameplay with real-time, variable jackpot contributions. The dynamic nature of the jackpot not only increases engagement but also allows casinos to control and promote specific gameplay periods, driving foot traffic and participation during off-peak hours or special events.

### Distinguishing Inventive Steps:

1. Dynamic Activation of Time-Sensitive Windows: The dealer activates a specific time window, during which player contributions to the jackpot are increased dynamically.
2. Real-Time Jackpot Display: ETGTs display real-time updates of how each player's bet is contributing to the jackpot during the active window.
3. Synchronized Casino Network Contribution Handling: The casino network dynamically adjusts jackpot contributions across multiple DETGs, ensuring a unified jackpot pool that grows rapidly during active periods.

These steps create a level of interactivity and urgency not found in conventional ETGTs or progressive jackpot systems.

### 35 USC 101 Considerations:

The technical implementation of Time-Sensitive Jackpot Boosts addresses a specific problem within the gaming industry: how to increase player engagement during less active periods. By dynamically adjusting the contribution rates to the jackpot pool based on specific time windows, this concept improves the functionality of the ETGT systems, enhancing player excitement and engagement.

The innovation is not a mere abstract idea but a practical application that integrates real-time data processing, network communication, and dynamic display updates. The system's ability to adjust contributions based on time windows represents a clear technological improvement over prior art. By solving the problem of fluctuating player engagement, the invention provides a patent-eligible advancement in casino gaming technology.

### Data Input:

Players input their bets through the ETGT, which transmits this information to the casino network. The time-sensitive nature of the jackpot boost means that the system must also collect data on the timing of the bet, ensuring it falls within the active window. The contribution percentages may be adjusted based on the size of the bet, the player's loyalty status, or other factors set by the casino.

### Component Interactions and Procedural Steps:

1. Dealer Activation: The dealer activates the jackpot boost window, signaling the system to adjust contribution percentages.
2. Player Bets: Each player places bets through their ETGT, which sends data to the casino network.
3. Real-Time Jackpot Calculation: The jackpot server calculates the boosted contributions and updates the jackpot display.
4. ETGT Display: Players see the jackpot increase in real-time on their terminals.

### Data Processing:

The system processes both the timing and amount of each bet to determine the contribution to the jackpot. This involves calculating the percentage contribution during active windows, updating the jackpot pool, and displaying real-time updates across all connected DETGs.

### Outputs and Responses:

The primary output is the dynamically updated jackpot display, visible to all players on their ETGTs. Additionally, the system may provide notifications when a jackpot window is about to close, encouraging players to place additional bets.

### Data Storage and Reporting:

The system stores records of all contributions, including timestamps, bet amounts, and player data, for auditing purposes. These records are reported to the casino's central tracking system.

### Error Handling and Security Measures:

Error handling mechanisms ensure that contributions outside the jackpot boost windows are calculated correctly. Security measures protect the integrity of the jackpot pool, preventing tampering with contributions.

### End of Interaction:

At the end of the jackpot boost window, the contribution rates revert to their normal levels, and the system resets, ready for the next activation period.

### Innovative Concept 41—Dealer-Initiated Jackpot Bonus Rounds

### Identification of Concept:

The Dealer-Initiated Jackpot Bonus Rounds innovative concept introduces an additional layer of excitement to Live Dealer-controlled multiplayer games by giving the dealer the ability to trigger special high-stakes jackpot opportunities. These bonus rounds may be initiated at the dealer's discretion, based on predefined rules set by the casino or in response to specific in-game triggers. This dynamic creates anticipation and adds strategic elements, allowing the dealer to introduce surprise high-reward rounds during gameplay, where players may increase their chances of winning a jackpot. This innovative concept aligns well with the pace of live dealer-controlled DETGs, where the human element enhances player engagement. Additionally, these bonus rounds may be tied to certain dealer performance metrics or casino promotional events, which incentivize both players and dealers to actively participate.

### Sequence Diagram Components:

Dealer: Acts as the initiator of the jackpot bonus rounds by selecting specific moments during gameplay to activate them.
Electronic Table Game Terminals (ETGTs): The interface through which players participate in the game and place wagers. These terminals communicate directly with the casino's gaming network to handle bonus round triggers and wagers.
Casino Network: Processes the bonus round activation, including adjusting betting parameters, tracking player wagers, and updating the jackpot pool in real-time.
Bonus Round Server: A dedicated server component that manages the logistics of bonus rounds, determining eligibility and calculating the jackpot payouts.
Players A and B: Engage with their ETGTs to place bets during the dealer-initiated bonus rounds, with the potential to win larger jackpots.
Jackpot Display: Displays real-time information about the current jackpot size and bonus round status, providing visual cues to players.

### Implementation Details:

Each ETGT within a Live Dealer Electronic Game Table System may be pre-configured to allow participation in dealer-initiated bonus rounds. The dealer initiates the bonus round by interacting with the dealer terminal, which sends a signal to the casino network. The casino network then activates the bonus round across all connected ETGTs in real time. The bonus round may alter the contribution to the jackpot, increase player payouts, or offer additional betting opportunities.

Once activated, the dealer's terminal interfaces with the bonus round server, which ensures that all necessary conditions are met, such as minimum bet amounts or player participation thresholds. Players are notified of the start of the bonus round through their ETGT displays and may opt to increase their bets to take advantage of the enhanced jackpot conditions. The system dynamically adjusts the contributions and potential payouts, ensuring that all players participating in the bonus round have their bets processed and tracked accurately.

This differs from conventional ETGTs where jackpots and bonus rounds are typically random or pre-determined. The dealer's ability to trigger bonus rounds adds a dynamic, human-driven element, allowing for flexibility and real-time adaptation to gameplay conditions.

### Example Walk-Through Scenario:

Imagine a scenario in which players are seated at a live dealer-controlled blackjack table with DETG integration. As the game progresses, the dealer notices heightened excitement among the players and decides to activate a Dealer-Initiated Jackpot Bonus Round. The dealer presses a button on their terminal, which immediately sends a signal to the casino network. All players are notified via their ETGTs, and a countdown timer appears, indicating that the bonus round will last for the next five minutes.

During this time, players A and B increase their bets to maximize their chances of hitting the enhanced jackpot. As they play through their hands, each bet placed during the bonus round contributes an additional percentage to the mystery jackpot pool. The dynamic jackpot display reflects this increase in real-time, showing the players how the pool grows during the bonus round.

At the end of the round, the dealer concludes the bonus session, and the system recalculates the contributions and adjusts the jackpot accordingly. If a mystery jackpot trigger occurs during this round, the winning player is awarded the enhanced jackpot payout, creating a memorable and exciting experience.

### Player Interaction:

Players interact with the dealer-initiated bonus round through their ETGTs. They are notified of the bonus round's activation via visual and auditory signals on their screens, prompting them to adjust their bets if desired. The increased stakes and potential for larger jackpots encourage players to engage more actively during the bonus round. In contrast to standard gameplay, this innovative concept offers a dynamic interaction where players must respond quickly to the dealer's decision to activate the round, creating a more involved and responsive experience.

### Distinguishing Innovative Concepts:

This innovative concept is distinguished by the real-time interaction between the dealer and players during jackpot gameplay. Traditional ETGTs rely on random or system-driven events to trigger bonus rounds or jackpots. The dealer-initiated aspect introduces a flexible, human element that adapts to live conditions. The dealer's ability to trigger a bonus round based on game flow or player engagement is a novel approach, allowing for more strategic and dynamic gameplay in live dealer-controlled DETGs. Additionally, this concept creates a unique advantage for casinos in being able to tailor jackpot rounds to peak moments of player activity.

### Distinguishing Inventive Steps:

1. Dealer Activation of Bonus Round: The dealer selects and activates a bonus round at their discretion, introducing an unpredictable and engaging element into the game.
2. Real-Time Dynamic Adjustment of Jackpot Contributions: During the bonus round, the system dynamically adjusts the percentage of player wagers contributing to the jackpot, increasing potential payouts.
3. Player Notification and Interaction: Players are instantly notified through their ETGTs and given the opportunity to adjust their bets, creating a more interactive and responsive gameplay experience.

These steps differentiate this innovative concept from conventional ETGTs by incorporating real-time dealer-driven gameplay changes that enhance player engagement.

### 35 USC 101 Considerations:

The technical implementation of Dealer-Initiated Jackpot Bonus Rounds addresses a specific problem: how to introduce dynamic, dealer-controlled events in a live DETG setting without disrupting normal gameplay. The invention improves upon prior art by integrating real-time network communication, dealer interaction, and dynamic jackpot contributions into a cohesive system that enhances the live gaming experience. It moves beyond a mere abstract idea by incorporating specific technological improvements that streamline communication between ETGTs, the casino network, and jackpot servers, ultimately enhancing the functionality of the live dealer-controlled DETG system.

### Data Input:

Players input their bets through their ETGTs as normal. Once the bonus round is activated, the system tracks these bets in real-time and adjusts contributions to the jackpot accordingly. The dealer's terminal also communicates with the casino network to initiate the bonus round.

### Component Interactions and Procedural Steps:

1. Dealer Activation: The dealer activates the bonus round using their terminal, which sends a signal to the casino network.
2. Player Bets: Players place their bets through ETGTs, which the system tracks and adjusts in real time.
3. Dynamic Jackpot Contributions: The bonus round server recalculates the contributions to the jackpot based on the new betting conditions.

### Data Processing:

The system processes each bet in real-time during the bonus round, dynamically adjusting the percentage allocated to the jackpot pool and updating the jackpot display across all ETGTs.

### Outputs and Responses:

The primary output is the enhanced jackpot display, which shows players how much has been contributed during the bonus round. Additionally, players receive real-time notifications when the bonus round is triggered and as it progresses.

### Data Storage and Reporting:

The system stores records of all bets placed during the bonus round, including timestamps and player IDs, for reporting and auditing purposes.

### Error Handling and Security Measures:

To ensure fair play, the system includes error handling mechanisms that validate all bets placed during the bonus round and ensure that no players are inadvertently excluded from the jackpot.

### End of Interaction:

At the end of the bonus round, the dealer concludes the session, and the system reverts to normal gameplay. All contributions and potential jackpots are updated accordingly, and the bonus round conditions are reset for the next activation.

### Innovative Concept 42—Jackpot Triggers Tied to Specific Win/Loss Sequences

### Identification of Concept:

This innovative concept introduces a mechanism where jackpot triggers are directly tied to specific win or loss sequences in Live Dealer-controlled multiplayer games. For instance, a player may qualify for a mystery jackpot if they experience a defined number of consecutive wins or losses during gameplay. This approach enhances engagement by rewarding extended streaks, both positive and negative, and motivates players to remain invested throughout longer gaming sessions. The system may track individual player sequences and calculate eligibility for the jackpot, offering an innovative alternative to random or standard jackpot triggers commonly seen in Electronic Table Game Terminals (ETGTs).

The win/loss sequence jackpot system is particularly well-suited for live dealer-controlled multiplayer games, such as baccarat or blackjack, where streaks are common and may vary widely between players. By introducing a jackpot tied to win/loss streaks, this concept appeals to players who enjoy the momentum of consecutive gameplay, adding a layer of anticipation and excitement beyond standard payouts.

### Sequence Diagram Components:

Electronic Table Game Terminals (ETGTs): Terminals through which players place bets, receive game outcomes, and track their win/loss sequences. These terminals are connected to the casino network for tracking the player's game history.
Live Dealer: Manages game flow and deals cards to the players, contributing to the outcomes that lead to win/loss streaks.
Casino Network: A central system that tracks player performance, including wins, losses, and consecutive game outcomes. This system also manages jackpot contributions and triggers when specific win/loss sequences are met.
Jackpot Server: Responsible for maintaining the mystery jackpot pool and determining if any player's win/loss sequence qualifies for a jackpot trigger.
Player A, Player B: Participants in the game, each with unique win/loss sequences that are tracked throughout their session. Both players may be eligible for jackpot triggers based on their respective sequences.
Display System: Updates players on their current win/loss sequence and shows the mystery jackpot status when a sequence-based trigger is close.

### Implementation Details:

To implement this concept, the casino network and ETGTs may be configured to track individual player outcomes across multiple rounds. Each player's win/loss sequence is monitored in real-time, and when a predefined sequence (e.g., five consecutive wins or losses) is achieved, the system triggers a potential jackpot event. This feature introduces an additional layer of excitement, especially when a player is on a hot or cold streak.

The ETGTs display real-time updates of each player's current sequence, notifying them when they are nearing a qualifying streak. Upon achieving the requisite sequence, the system sends the information to the jackpot server, which processes the event and determines if a mystery jackpot payout is warranted. This system may be deployed across multiple DETGs, ensuring that all players have an opportunity to benefit from this innovative concept.

The primary novelty lies in the fact that the trigger is based on win/loss sequences rather than random events or fixed contribution thresholds. This approach transforms the gaming experience by rewarding extended gameplay and allowing players to experience a buildup of anticipation based on their in-game performance.

### Example Walk-Through Scenario:

Imagine a scenario where Player A is seated at a live dealer baccarat table, and Player B is playing at a blackjack table, both connected to the same DETG network. Player A is on a hot streak, winning four consecutive rounds, while Player B is on a losing streak, having lost five consecutive hands. Both players are notified through their ETGTs that they are nearing a potential mystery jackpot trigger based on their respective sequences.

As Player A wins their fifth consecutive baccarat hand, the system identifies this sequence and triggers a mystery jackpot. The ETGT displays the updated jackpot amount, and the casino network processes the contribution and potential payout. Simultaneously, Player B loses their sixth hand, which also qualifies them for a potential jackpot, creating a moment of excitement for both players.

The real-time tracking of sequences and the dynamic triggering of jackpots create a new level of engagement, motivating players to continue playing in hopes of achieving a qualifying streak.

### Player Interaction:

Players interact with this innovative concept through their ETGTs, which track their win/loss sequences in real time. The terminals display sequence progress, notifying players when they are close to a jackpot-triggering streak. This interactive element encourages players to remain engaged, as each round brings them closer to a potential jackpot event.

In contrast to conventional ETGTs, where jackpot triggers are often random or based on simple bet thresholds, this system rewards consistent gameplay performance, adding a level of strategy and anticipation to the experience. Players are encouraged to keep playing, even during losing streaks, as they understand that a long streak may result in a jackpot trigger.

### Distinguishing Innovative Concepts:

The notable distinguishing factor of this concept is its reliance on player-specific win/loss sequences to trigger a mystery jackpot. Unlike conventional ETGT systems where triggers are random or based on collective contributions, this system focuses on individual player performance, rewarding players for both streaks of wins and losses. This approach adds a unique and personal dimension to jackpot gameplay, as players feel more in control of their potential outcomes.

Additionally, the ability to track and reward both win and loss sequences is novel. Most traditional systems focus on rewarding positive outcomes, but by incorporating loss streaks, this system provides a balanced experience, offering excitement even when a player is on a losing streak.

### Distinguishing Inventive Steps:

1. Tracking Individual Win/Loss Sequences: The system tracks player outcomes across multiple rounds, identifying qualifying streaks for potential jackpot triggers.
2. Real-Time Jackpot Trigger Notification: When a player achieves a qualifying streak, the system immediately notifies them of the jackpot trigger, adding an element of surprise and excitement.
3. Dual Reward Mechanism for Win/Loss Sequences: The system rewards both winning and losing streaks, offering players additional chances for jackpot payouts regardless of their game performance.

These steps distinguish this innovative concept from conventional ETGT systems, which typically rely on random or contribution-based triggers.

### 35 USC 101 Considerations:

The technical implementation of Jackpot Triggers Tied to Specific Win/Loss Sequences offers a tangible improvement over existing systems by incorporating real-time tracking and personalized jackpot triggers based on player performance. This concept moves beyond abstract ideas by integrating specific technical advancements, such as dynamic sequence tracking and real-time jackpot calculations, that enhance player engagement and improve the overall gaming experience.

By providing a method for tracking player performance and offering personalized jackpot opportunities, this system represents a clear improvement in the functionality of live dealer-controlled DETGs and ETGTs.

### Data Input:

Players input their bets and participate in rounds through their ETGTs. The system tracks the outcome of each round for each player, logging wins and losses in real-time. This data is sent to the casino network, which determines when a player achieves a qualifying sequence.

### Component Interactions and Procedural Steps:

1. Player Bets and Outcomes: Each player's outcome is logged after each round, with win/loss sequences tracked continuously.
2. Sequence Tracking: The casino network processes these outcomes and updates the player's sequence count.
3. Jackpot Trigger: When a qualifying sequence is achieved, the system triggers the mystery jackpot, notifying the player and updating the jackpot pool.

### Data Processing:

The system processes the win/loss sequences for each player in real-time, dynamically updating the sequence count and determining when a jackpot trigger occurs. This involves tracking the outcomes across multiple rounds and calculating the player's eligibility for a jackpot payout.

### Outputs and Responses:

The primary output is the jackpot trigger notification displayed on the player's ETGT. The system also updates the jackpot pool and recalculates the contributions based on the player's sequence.

### Data Storage and Reporting:

All player outcomes and sequence data are stored in the casino's central database for auditing and reporting purposes. This data is used to verify jackpot triggers and ensure fair play.

### Error Handling and Security Measures:

Error handling mechanisms ensure that all sequences are tracked accurately, and security measures protect the integrity of the jackpot triggers, ensuring that players cannot manipulate their outcomes to achieve a qualifying sequence.

### End of Interaction:

When a jackpot trigger occurs, the system processes the payout, and the player's sequence count resets. The system then returns to normal gameplay, ready to track the next win/loss sequence.

### Innovative Concept 43—Mystery Jackpot Pool Sharing Between Adjacent Players

### Identification of Concept:

The Mystery Jackpot Pool Sharing Between Adjacent Players innovative concept adds a communal element to the mystery jackpot system by distributing a portion of the jackpot to players seated next to the jackpot winner. In a live dealer-controlled multiplayer game environment, when a player triggers a mystery jackpot, adjacent players may receive a share of the jackpot prize, thus fostering a sense of shared excitement and camaraderie. This concept not only incentivizes individual play but also encourages players to stay longer at the table, knowing they may benefit from their neighbor's success.

This innovative concept fits particularly well within Electronic Table Game Terminal (ETGT) systems in a live dealer setting, where multiple players are engaged simultaneously. The proximity of players increases the social element, and the potential for shared winnings adds an additional layer of strategy, as players may choose seats based on the perceived skill or luck of others at the table. The shared pool distribution may vary depending on the total number of adjacent players, the size of their bets, or the specific game being played.

### Sequence Diagram Components:

Electronic Table Game Terminals (ETGTs): The individual player terminals that are connected to the casino network and allow players to place wagers, participate in the game, and be eligible for jackpot prizes. Each terminal tracks the position of the player relative to other players.
Live Dealer: Facilitates gameplay and monitors the triggering of jackpot events. The dealer announces jackpot triggers and communicates with the casino network to handle pool sharing.
Casino Network: Manages the jackpot pool and calculates how the pool is distributed among the winning player and adjacent players. It tracks player positions, their bet amounts, and ensures fair and accurate distribution of the jackpot.
Jackpot Server: Manages the overall jackpot pool, handles contributions, and processes mystery jackpot triggers. It dynamically adjusts the total pool and allocates shares based on adjacent player positions.
Player A (Jackpot Winner): The player who triggers the jackpot based on predefined criteria, receiving the primary payout.
Player B, Player C (Adjacent Players): The players seated adjacent to Player A, who receive a portion of the mystery jackpot as part of the pool-sharing system.
Dynamic Display System: Shows real-time updates of the jackpot pool, contributing excitement by visually representing the shared distribution of winnings among players.

### Implementation Details:

In this innovative concept, each ETGT system tracks the seating positions of players relative to one another. When a mystery jackpot event is triggered by one player, the system automatically calculates which players are seated adjacent to the winner, based on the layout of the table and the seating configuration. The adjacent players are then allocated a portion of the jackpot pool, determined either by a fixed percentage of the jackpot or based on additional criteria such as their bet size or participation during the game session.

The system may be implemented by configuring the ETGTs and the casino network to automatically detect and update player positions in real-time. Each time a new player joins the game, the system tracks their position relative to others, ensuring that when a jackpot is triggered, the adjacent players are correctly identified. The ETGTs display the player's status regarding proximity to other players and whether they qualify for a portion of a jackpot if their neighbor wins.

This implementation differs from traditional ETGT systems that usually only focus on the individual who triggered the jackpot. The shared pool distribution adds a communal element and incentivizes players to remain seated, knowing that they have a chance to win even when another player triggers the jackpot.

### Example Walk-Through Scenario:

Consider a live dealer baccarat table with multiple players, each seated at their own ETGT. Player A, seated in the center, has been betting aggressively and contributes to the mystery jackpot pool with each wager. Player B is seated directly to the left of Player A, and Player C is seated to the right.

During one round of play, Player A triggers the mystery jackpot by meeting the game's predefined criteria. As soon as the jackpot is triggered, the system identifies Player B and Player C as adjacent players. The casino network automatically calculates the distribution, allocating 70% of the jackpot to Player A, 15% to Player B, and 15% to Player C. The ETGTs of Players B and C display the updated jackpot information, showing their share of the winnings. The live dealer announces the jackpot trigger, enhancing the communal excitement.

Player A, as the primary jackpot winner, receives the bulk of the prize, while Players B and C enjoy their share, creating a sense of shared victory. This encourages players to continue playing together, increasing the likelihood that they will remain engaged for extended periods.

### Player Interaction:

Players interact with the mystery jackpot pool-sharing system through their ETGTs, which provide real-time updates on their seating position and proximity to potential jackpot winners. Players are informed when they are seated adjacent to a player who may potentially trigger the jackpot, adding an element of anticipation. Additionally, the dynamic nature of the pool-sharing system encourages players to stay in their seats, as they understand that even if they don't trigger the jackpot themselves, they may still benefit from their neighbor's success.

This contrasts with traditional ETGTs or slot machines, where each player's outcomes are independent of one another. By introducing a shared reward element, this concept encourages more communal interaction and creates a shared experience, which is rare in standard mystery jackpot systems.

### Distinguishing Innovative Concepts:

The notable novelty of this concept lies in the communal aspect of jackpot winnings. In contrast to conventional mystery jackpot systems, which only reward the player who triggered the event, this system distributes a portion of the winnings to adjacent players, creating a more socially engaging environment. This approach encourages players to remain at the table longer, knowing that they may win through proximity to other players, even if they do not trigger the jackpot themselves.

This shared pool distribution is also unique in that it may vary based on the number of adjacent players, the size of their bets, or their loyalty status. This level of personalization is a distinguishing factor from traditional ETGTs or progressive jackpot systems.

### Distinguishing Inventive Steps:

1. Real-Time Player Position Tracking: The system dynamically tracks player positions in relation to the jackpot winner, ensuring accurate and fair distribution of the jackpot pool.
2. Automatic Jackpot Pool Sharing: When a mystery jackpot is triggered, the system automatically calculates and distributes a portion of the winnings to adjacent players.
3. Dynamic Jackpot Display: The jackpot display updates in real-time, showing both the primary and secondary winners, enhancing the overall player experience.

These steps distinguish this innovative concept from traditional mystery jackpot systems, which are typically focused on individual payouts without communal sharing.

### 35 USC 101 Considerations:

The technical implementation of Mystery Jackpot Pool Sharing Between Adjacent Players offers a clear improvement over existing jackpot systems by incorporating real-time player tracking, dynamic jackpot distribution, and communal engagement features. By introducing the ability to track player proximity and distribute a portion of the jackpot to adjacent players, this system enhances the functionality of live dealer-controlled DETGs and adds a social dimension that is absent in standard ETGT systems.

This system moves beyond an abstract idea by providing specific technical advancements in player tracking, real-time data processing, and dynamic jackpot management, ensuring a seamless and engaging experience for all players.

### Data Input:

Players input their bets through their ETGTs, which are tracked by the system in real-time. The system also tracks player seating positions relative to one another, ensuring that adjacent players are identified correctly when a jackpot is triggered.

### Component Interactions and Procedural Steps:

1. Player Bets and Positions: Each player's bet is logged, and their position relative to others is tracked by the casino network.
2. Jackpot Trigger and Pool Sharing: When a jackpot is triggered, the system automatically calculates the distribution and shares the jackpot with adjacent players.
3. Dynamic Display Updates: The system updates the jackpot display, showing the distribution of winnings among the primary and adjacent players.

### Data Processing:

The system processes each player's position in real-time and determines which players are eligible for pool-sharing. The system also calculates the appropriate share of the jackpot for each adjacent player and processes the winnings accordingly.

### Outputs and Responses:

The primary output is the distribution of the jackpot winnings across the adjacent players, which is displayed on their ETGTs. The system also updates the central jackpot display, showing how much of the jackpot has been distributed to each eligible player.

### Data Storage and Reporting:

The system stores records of all jackpot events, including the distribution of winnings and player positions. This data is used for auditing purposes and ensures transparency in the jackpot-sharing process.

### Error Handling and Security Measures:

The system includes error handling mechanisms to ensure that player positions are accurately tracked and that all eligible players receive their share of the jackpot. Security measures are in place to prevent tampering with the jackpot distribution.

### End of Interaction:

Once the jackpot has been distributed, the system resets and prepares for the next potential jackpot trigger. All player positions and bet amounts are recalibrated, ensuring that the system is ready for the next round of play.

### Innovative Concept 44—Dynamic Mystery Jackpot Reveal Animations

### Identification of Concept:

Dynamic Mystery Jackpot Reveal Animations introduce an immersive and visually engaging experience in Live Dealer-controlled multiplayer games and DETG systems by utilizing adaptive animations when mystery jackpots are triggered. These animations may evolve based on the trigger conditions, the player's betting history, or other predefined factors. The primary goal of this feature is to enhance player engagement and excitement during the jackpot reveal process by adding suspense and personalization to the visual display of the jackpot award. As the reveal is linked to specific game events, it ensures that each jackpot win feels unique and customized, adding to the overall entertainment value.

This feature integrates seamlessly with Electronic Table Game Terminals (ETGTs) by utilizing high-definition displays and animations that visually represent the progression and reveal of jackpot amounts. Players may see animations unfold directly on their screens when they trigger or participate in a jackpot event, with visual effects tailored to enhance the player's sense of achievement.

### Sequence Diagram Components:

Electronic Table Game Terminals (ETGTs): Terminals that display the dynamic jackpot reveal animations to players. These terminals communicate with the jackpot server to retrieve and display real-time jackpot animations.
Live Dealer: Facilitates the overall game, interacts with players, and may trigger or announce the jackpot event. The dealer's terminal may also display elements of the jackpot reveal.
Casino Network: Manages the data communication between the ETGTs and jackpot servers, transmitting the jackpot triggers, player betting history, and animation details.
Jackpot Server: Calculates jackpot winnings, manages the dynamic reveal conditions, and transmits data to the ETGTs for real-time animation rendering.
Animation Engine: A software component responsible for generating adaptive animations based on predefined conditions such as player history, bet size, and jackpot trigger criteria. It interfaces with the jackpot server to ensure synchronization of visual effects with jackpot outcomes.

### Implementation Details:

Each ETGT within the Live Dealer-controlled DETG system may be equipped with high-resolution screens capable of displaying dynamic animations. When a player triggers a mystery jackpot, the system retrieves animation templates from the animation engine, which adapts the visuals based on several factors. For instance, if the player has been betting consistently, the animation may show a build-up of tension, culminating in a dramatic reveal of the jackpot amount.

The animation engine interfaces with the jackpot server to ensure that the displayed jackpot amount matches the actual win, creating a seamless and synchronized experience. The animation itself may vary depending on the magnitude of the jackpot, the length of the gameplay session, or specific game triggers. For example, in a blackjack game, the animation may simulate cards flipping dramatically before revealing the jackpot amount, while in a roulette game, it may involve a spinning wheel that slowly lands on the winning jackpot.

This implementation differs from conventional jackpot systems, which typically use static or basic animations. By adding dynamic, real-time animations that adapt to gameplay conditions, this concept enhances player engagement and creates a more immersive experience.

### Example Walk-Through Scenario:

Imagine a scenario at a live dealer-controlled baccarat game. Player A has been steadily increasing their bets, hoping to trigger a mystery jackpot. After several rounds, Player A hits the jackpot trigger. As soon as the trigger is activated, Player A's ETGT begins displaying a dramatic animation: a virtual baccarat card flips slowly on the screen, revealing increasing jackpot amounts as it does so. The jackpot amount builds in suspense, with additional visual effects such as fireworks or cascading coins, before finally revealing the full jackpot amount in a burst of excitement.

Simultaneously, other players at the table may see a smaller animation on their own ETGTs, indicating that Player A has won the jackpot. This animation is personalized based on Player A's gameplay and betting patterns, ensuring that the experience feels unique. The live dealer also interacts with the reveal, congratulating Player A and enhancing the communal atmosphere of the win.

### Player Interaction:

Players engage with the dynamic mystery jackpot reveal through their ETGTs, where they see real-time animations unfold based on their jackpot triggers. The reveal animations are personalized, creating a sense of ownership and uniqueness in the win. Players may interact by following the suspenseful build-up of the animation, watching as the jackpot amount is revealed over time, rather than instantly.

Compared to traditional mystery jackpots, where the win is simply displayed on a screen, this innovative concept introduces an interactive element that heightens player excitement. The evolving nature of the animation keeps players engaged and focused, making the jackpot win feel more impactful and rewarding.

### Distinguishing Innovative Concepts:

The notable distinction of this innovative concept lies in its adaptive, dynamic animations. Traditional ETGTs rely on static graphics or simple displays to show jackpot winnings, but this concept introduces a system where the reveal is linked to the specific conditions of the jackpot trigger. The animations are personalized based on player behavior, the size of the win, and other factors, making each reveal unique.

By incorporating these dynamic visuals, the system enhances player engagement and provides a richer, more immersive experience. This approach is particularly beneficial in live dealer environments, where the social and emotional aspects of gameplay are notable.

### Distinguishing Inventive Steps:

1. Adaptive Animation Engine: The system dynamically generates reveal animations based on player-specific factors, creating a personalized visual experience.
2. Real-Time Jackpot Synchronization: The jackpot server and animation engine work together to ensure the animations accurately reflect the real-time jackpot win amounts.
3. Personalized Visual Effects: The animations are tailored to reflect the player's betting history, gameplay session length, and other relevant factors, ensuring that no two reveals are the same.

These steps highlight one aspect of novelty of using dynamic animations to enhance the visual and emotional impact of mystery jackpot reveals, setting this system apart from conventional ETGT jackpot implementations.

### 35 USC 101 Considerations:

The technical implementation of Dynamic Mystery Jackpot Reveal Animations offers a clear improvement in gaming functionality by integrating personalized, real-time animations with jackpot triggers. This concept moves beyond abstract ideas by solving a specific problem-enhancing player engagement during jackpot events-through innovative use of adaptive animation technology.

By synchronizing the animation with the jackpot server and tailoring the reveal based on individual player behavior, this concept provides a unique technical solution that improves the player experience in live dealer-controlled DETGs. The system's use of dynamic animations that evolve based on real-time data adds a patent-eligible advancement to existing gaming systems.

### Data Input:

The system gathers data from each player's ETGT, including bet amounts, game outcomes, and jackpot triggers. The data is transmitted to the jackpot server, which processes the win and communicates with the animation engine to generate the appropriate reveal animation.

### Component Interactions and Procedural Steps:

1. Player Bets and Jackpot Trigger: The system tracks player bets and determines when a jackpot trigger occurs.
2. Animation Selection and Rendering: The animation engine selects and renders a personalized reveal animation based on player data and the jackpot size.
3. Real-Time Synchronization: The jackpot server and ETGTs work together to ensure that the displayed animations match the actual jackpot amounts.

### Data Processing:

The system processes player betting data, game outcomes, and jackpot triggers to generate appropriate animations. The animation engine adapts the visual effects based on predefined conditions, ensuring that each reveal is unique and personalized.

### Outputs and Responses:

The primary output is the dynamic jackpot reveal animation displayed on the ETGT screens. The system may also provide notifications to other players when a jackpot is triggered, creating a shared experience.

### Data Storage and Reporting:

The system stores player data, jackpot triggers, and animation logs in the casino's central database. This data is used for auditing purposes and to analyze player engagement with the dynamic reveal feature.

### Error Handling and Security Measures:

Error handling mechanisms ensure that the animations are synchronized correctly with the jackpot server and that the correct amounts are displayed. Security measures are in place to prevent tampering with the jackpot triggers or animations.

### End of Interaction:

Once the jackpot is fully revealed, the animation concludes, and the ETGT returns to normal gameplay. The system resets, ready to trigger the next dynamic jackpot reveal.

### Innovative Concept 45—Dealer-Specific Mystery Jackpots

### Identification of Concept:

The Dealer-Specific Mystery Jackpots innovative concept introduces a unique twist by associating mystery jackpots with individual dealers in Live Dealer-controlled multiplayer games. Under this system, each dealer has a specific jackpot pool that grows as they conduct game sessions. Players are encouraged to participate in games led by their favorite dealers, knowing that the longer a dealer runs a table, the larger the potential mystery jackpot becomes. This approach builds player loyalty and engagement, as players may return to specific dealers in hopes of triggering their personal dealer-associated jackpot.

This system may be implemented within Dealer-controlled Electronic Table Games (DETGs) and supports various game types, including blackjack, baccarat, and roulette. The jackpot contributions are tracked and managed by the casino's backend systems, which calculate how much of each player's bet is allocated to the dealer-specific mystery jackpot. When a player at that dealer's table hits certain game outcomes, the jackpot is triggered, and the associated pool is awarded.

### Sequence Diagram Components:

Electronic Table Game Terminals (ETGTs): The interface through which players place bets and monitor the status of the dealer-specific mystery jackpot. The terminal tracks contributions made toward the dealer's jackpot pool and provides real-time updates.
Live Dealer: The dealer whose game session contributes to the growth of the dealer-specific mystery jackpot. The dealer's actions influence the accumulation of the jackpot pool, and they announce the winner when the jackpot is triggered.
Casino Network: Tracks each dealer's game session, logs player contributions, and manages the dealer-specific jackpot pools. It also triggers the jackpot payout when the required conditions are met.
Jackpot Server: Responsible for calculating dealer-specific jackpot contributions, storing the jackpot amounts, and managing the conditions under which the jackpot is triggered.
Player A, Player B: Players seated at the table who contribute to the dealer-specific jackpot pool. Player A may trigger the jackpot, while Player B, participating in the same game session, observes and potentially benefits from shared winnings.
Jackpot Display: A visual display of the dealer-specific mystery jackpot, showing real-time updates of its size and notifying players when it is triggered.

### Implementation Details:

In this innovative concept, each dealer within the Live Dealer-controlled DETG system has their own associated mystery jackpot. The ETGTs connected to the dealer's table track player bets and allocate a portion of each bet to the dealer's specific jackpot pool. This pool grows as long as the dealer is running the table. The casino network system dynamically updates the jackpot value and displays it in real-time on each player's terminal and on a central screen for the entire table.

The jackpot may be triggered by a variety of conditions, such as a player hitting a particular game outcome (e.g., a specific card combination in blackjack) or a certain number of players participating in the game. When the jackpot is triggered, the player who achieved the game outcome receives the full or partial amount from the dealer-specific jackpot pool.

This concept differs from conventional mystery jackpot systems in which jackpots are shared across all tables or randomly triggered. By tying the jackpot to individual dealers, the system introduces a personalized and strategic layer of gameplay. Players may opt to follow specific dealers whose jackpots have accumulated larger pools, adding a social and loyalty-driven aspect to the gaming experience.

### Example Walk-Through Scenario:

Imagine a scenario where players are seated at a blackjack table managed by Dealer X. Over the course of several game sessions, the players' bets contribute a percentage to Dealer X's mystery jackpot pool. Player A has been regularly playing at Dealer X's table, aware that the jackpot pool is growing. After several rounds, Player A receives a blackjack hand that triggers the jackpot, immediately winning the accumulated amount.

As the jackpot is triggered, the ETGTs for all players display a notification, and Dealer X announces the event. The jackpot display shows the final amount awarded to Player A, while Player B and others at the table witness the excitement unfold. The system resets Dealer X's mystery jackpot pool, and the process begins again.

Players may choose to remain at Dealer X's table, hoping to trigger another jackpot, or switch to other dealers whose jackpots may offer larger potential payouts. This mechanic fosters dealer loyalty and encourages longer gameplay sessions, as players track and anticipate dealer-specific jackpots.

### Player Interaction:

Players interact with the dealer-specific mystery jackpot system through their ETGTs. The terminals display real-time updates on the jackpot pool associated with their dealer, encouraging players to remain engaged. As the jackpot pool grows, players may strategically decide to continue playing at the same table or switch to another dealer whose jackpot pool may offer better odds of a payout.

This system introduces a competitive and social element, as players may feel a sense of loyalty toward specific dealers or follow the dealer with the largest jackpot pool. Compared to traditional mystery jackpots, this system personalizes the jackpot experience by tying it to the dealer, enhancing the sense of involvement and excitement for the player.

### Distinguishing Innovative Concepts:

The notable distinguishing feature of this innovative concept is its focus on dealer-specific jackpots. Unlike conventional ETGT systems where jackpots are shared across tables or triggered randomly, this system ties the jackpot directly to the dealer, creating a more personalized and strategic experience. Players are incentivized to follow specific dealers and participate in their sessions, adding a unique dynamic to the gaming environment.

The concept also introduces a sense of progression, as players may watch their favorite dealer's jackpot grow over time, creating anticipation and excitement that is distinct from traditional, more passive jackpot systems.

### Distinguishing Inventive Steps:

1. Dealer-Specific Jackpot Pool Accumulation: The system allocates a portion of player bets to the dealer's specific jackpot pool, allowing the pool to grow over the course of the dealer's game sessions.
2. Real-Time Jackpot Pool Tracking: ETGTs and central displays provide real-time updates on the size of the dealer-specific jackpot pool, adding transparency and excitement for the players.
3. Personalized Jackpot Triggers: The jackpot trigger conditions are tied to the player's performance at the dealer's table, offering a customized experience that enhances player engagement.

These steps differentiate this innovative concept from conventional jackpot systems, which are typically shared across multiple tables and lack the personalized element of dealer-specific rewards.

### 35 USC 101 Considerations:

The technical implementation of Dealer-Specific Mystery Jackpots offers a clear improvement in gaming systems by introducing dealer-specific jackpot tracking and real-time player engagement. This system solves the problem of passive jackpot systems by integrating player behavior and dealer actions into the jackpot accumulation process, providing a more dynamic and engaging experience.

This innovative concept is not an abstract idea but a concrete application that improves the functionality of Live Dealer-controlled DETGs by adding personalized, dealer-specific jackpots. The system's ability to track individual dealer sessions, accumulate jackpots, and trigger rewards based on player outcomes represents a clear advancement in casino gaming technology.

### Data Input:

Players input their bets through ETGTs, which are tracked in real-time. The casino network allocates a portion of each bet to the dealer-specific jackpot pool, ensuring that the jackpot grows over time. Additionally, game outcomes are tracked to determine when a jackpot trigger occurs.

Component Interactions and Procedural Steps:
1. Player Bets and Contributions: Each player's bet is processed, and a percentage is allocated to the dealer-specific jackpot pool.
2. Jackpot Pool Growth and Display: The dealer's jackpot pool grows over time, with real-time updates displayed on ETGTs and central jackpot displays.
3. Jackpot Trigger: When a player meets the predefined conditions, the system triggers the dealer-specific jackpot, and the player receives the payout.

### Data Processing:

The system processes player bets and contributions to the dealer-specific jackpot pool in real-time, updating the pool value as each game session progresses. The system also calculates when a jackpot trigger occurs and manages the distribution of winnings to the player.

### Outputs and Responses:

The primary output is the jackpot trigger notification displayed on the ETGT screens, showing the player who triggered the jackpot and the amount won. The system also updates the central display with the final jackpot pool value and resets the pool for the next game session.

### Data Storage and Reporting:

The system stores records of all dealer-specific jackpot contributions and triggers, ensuring that accurate data is available for auditing and reporting purposes.

### Error Handling and Security Measures:

The system includes error handling mechanisms to ensure that player contributions are correctly allocated to the dealer's jackpot pool and that jackpot triggers are processed accurately. Security measures are in place to prevent tampering with jackpot pools or triggers.

### End of Interaction:

Once the dealer-specific jackpot is triggered, the system resets the pool and prepares for the next game session. Players may choose to stay at the same dealer's table or move to another dealer with a larger jackpot pool.

### Innovative Concept 46—Time-Limited Jackpot Opportunities

### Identification of Concept:

The Time-Limited Jackpot Opportunities innovative concept introduces jackpots that are only available for a fixed period, encouraging players to place bets within a specific timeframe to qualify for the jackpot. These time-limited events may be set to run during peak hours, special casino promotions, or during specific intervals throughout the day. The jackpots may start with a base amount and grow as players place bets within the designated period, and once the time expires, the jackpot either resets or is awarded to a player who meets predefined criteria.

This concept is designed to heighten player excitement and urgency, as the limited window for participation creates a sense of exclusivity and competition. In live dealer-controlled DETG systems, the dealer may announce the start of a time-limited jackpot opportunity, and all players participating within the timeframe may contribute to and potentially win the jackpot. The concept works particularly well in multiplayer game settings such as blackjack, roulette, and baccarat.

### Sequence Diagram Components:

Electronic Table Game Terminals (ETGTs): The player's primary interface for placing bets and tracking the remaining time on the jackpot opportunity. The terminals display countdowns and visual indicators that notify players when a time-limited jackpot is active.
Live Dealer: Oversees the game and announces the start and end of the time-limited jackpot. The dealer's role is to keep players informed and engaged during the limited timeframe.
Casino Network: Tracks player bets, monitors the countdown for the time-limited jackpot, and processes jackpot contributions during the active period. The network also triggers the jackpot payout or resets the pool once the timeframe expires.
Jackpot Server: Manages the specific time-limited jackpot pool, calculating contributions based on player bets and determining the conditions for jackpot payout. It handles the logic for resetting or awarding the jackpot at the end of the timeframe.
Player A, Player B: Multiple players who participate in the game during the time-limited jackpot opportunity. Each player contributes to the jackpot pool, and their participation is tracked to determine eligibility for a payout.
Countdown Display: A timer that shows the remaining time for the jackpot opportunity, ensuring that players are aware of the limited window for qualifying bets. The display is visible on the ETGTs and optionally on a central display for all players at the table.

### Implementation Details:

In this innovative concept, the casino network and ETGTs are configured to handle time-limited jackpot events. When the casino decides to activate a time-limited jackpot, the live dealer announces the event, and the ETGTs immediately update with a countdown timer showing how much time remains for players to place qualifying bets. During this period, a portion of each bet is allocated to the time-limited jackpot pool, and the jackpot value grows dynamically based on the total contributions.

Once the countdown reaches zero, the system either awards the jackpot to a qualifying player based on predefined criteria (e.g., achieving a specific game outcome) or resets the pool for the next time-limited event. If no player meets the conditions for a jackpot payout, the pool may roll over to the next time-limited jackpot opportunity, increasing the excitement for future rounds.

This system differs from traditional mystery jackpots by introducing a fixed timeframe, which creates urgency and encourages players to place more bets during the active period. The time-limited feature may also be used to drive higher participation during off-peak hours or special casino promotions, making it a versatile tool for casino operators.

### Example Walk-Through Scenario:

Imagine a scenario at a live dealer-controlled roulette table where the dealer announces the start of a 15-minute time-limited jackpot opportunity. Players A and B, along with several others, are seated at their ETGTs. As soon as the announcement is made, a countdown timer appears on all ETGT screens, indicating that players have 15 minutes to place their bets to qualify for the jackpot.

Player A places a series of bets throughout the countdown, each contributing a percentage to the growing jackpot pool. Meanwhile, Player B also places qualifying bets, watching the jackpot amount increase in real-time. As the timer reaches the final minutes, both players increase their bet amounts, hoping to hit a qualifying game outcome before the time expires.

With only seconds remaining, Player A hits a winning number on the roulette wheel, triggering the jackpot payout. The jackpot server processes the win, and Player A is awarded the entire jackpot pool. The system announces the win, resets the countdown, and prepares for the next time-limited jackpot opportunity.

### Player Interaction:

Players interact with the time-limited jackpot through their ETGTs, which display real-time updates of the remaining time and the growing jackpot pool. As the countdown progresses, players are encouraged to place more bets, knowing that their contributions help increase the jackpot amount. The limited timeframe creates a sense of urgency and competition, as players race against the clock to secure a potential jackpot win.

Compared to traditional jackpot systems, this time-limited approach introduces a dynamic and fast-paced element that keeps players engaged. Players must act quickly and strategically to maximize their chances of winning during the active period, adding a layer of excitement that enhances the overall gaming experience.

### Distinguishing Innovative Concepts:

The notable novelty of this innovative concept is the use of a fixed timeframe to trigger and award a jackpot. Unlike conventional mystery jackpots, which are typically random or based on fixed bet thresholds, this system relies on a time-sensitive window that forces players to make quick decisions and engage more actively during the countdown. The concept also allows casinos to strategically implement time-limited jackpots during specific periods to drive participation.

The system's ability to display a dynamic countdown and adjust the jackpot pool in real-time adds to its unique appeal, making it more interactive and engaging than traditional jackpot systems.

### Distinguishing Inventive Steps:

1. Activation of Time-Limited Jackpot: The dealer or casino system activates a jackpot that is only available for a set timeframe, with contributions tracked dynamically during the countdown.
2. Real-Time Countdown Display: ETGTs display a countdown timer, visually reinforcing the limited window for players to place qualifying bets.
3. Dynamic Jackpot Growth: The jackpot pool grows in real-time based on player contributions during the active period, with the potential for a payout at the end of the countdown.

These steps distinguish this innovative concept from standard progressive jackpots, which do not typically incorporate time-based constraints or dynamic player interaction.

### 35 USC 101 Considerations:

The technical implementation of Time-Limited Jackpot Opportunities offers a clear advancement over existing systems by integrating real-time countdowns, dynamic player engagement, and time-based jackpot triggers. The system's reliance on a fixed timeframe introduces a novel way of structuring jackpots, creating urgency and driving player interaction in a way that is fundamentally different from abstract, random jackpot triggers.

This innovative concept provides a concrete improvement to the functionality of Live Dealer-controlled DETGs, offering a specific solution to the problem of maintaining player engagement over short periods. The system's ability to track and process player contributions within a defined timeframe adds a unique technological solution that enhances the player experience.

Data Input: Players input their bets through ETGTs, and the system tracks the timing and amount of each bet in real-time.

The data is used to calculate contributions to the time-limited jackpot pool, ensuring that only bets placed within the active window are eligible for the jackpot.

### Component Interactions and Procedural Steps:

1. Dealer Announcement and Activation: The dealer announces the start of the time-limited jackpot, and the system activates the countdown timer across all ETGTs.
2. Player Bets and Contributions: Players place their bets, and the system allocates a portion to the time-limited jackpot pool while updating the countdown display.
3. Jackpot Trigger or Reset: At the end of the countdown, the system either awards the jackpot to a qualifying player or resets the pool for the next time-limited opportunity.

### Data Processing:

The system processes player bets in real-time, dynamically updating the jackpot pool and the countdown display. It also calculates when a jackpot trigger occurs based on predefined game outcomes and manages the distribution of winnings at the end of the countdown.

### Outputs and Responses:

The primary output is the countdown display on the ETGTs, showing the remaining time and the current jackpot amount. At the end of the countdown, the system either triggers the jackpot payout or resets the pool for the next round.

### Data Storage and Reporting:

The system stores records of all player bets, jackpot contributions, and countdown events, ensuring accurate tracking for auditing and reporting purposes.

### Error Handling and Security Measures:

The system includes error handling mechanisms to ensure that only bets placed within the active countdown period are eligible for the jackpot. Security measures are in place to prevent tampering with the countdown timer or jackpot pool.

### End of Interaction:

Once the countdown expires, the system either triggers a jackpot payout or resets the pool, preparing for the next time-limited jackpot opportunity. Players are notified of the outcome, and the system returns to normal gameplay.

### Innovative Concept 47—Dynamic Jackpot Pooling

### Identification of Concept:

Dynamic Jackpot Pooling introduces a feature where the jackpot pool size increases based on real-time data such as the number of players betting within a specific timeframe. The concept may be implemented in a live dealer-controlled environment, where the jackpot amount rises dynamically based on active player participation across Electronic Table Game Terminals (ETGTs). For instance, the more players place bets within a certain period (e.g., during peak hours or special promotions), the faster the jackpot pool grows. This not only increases player excitement but also fosters a competitive atmosphere where players are incentivized to join during peak participation times.

This innovative concept may be particularly engaging in games like blackjack, roulette, or baccarat, where player volume may fluctuate. The dynamic nature of the pool encourages more players to join or increase their betting activity as they witness the pool size increase in real time. This concept may be implemented alongside other jackpot features such as time-limited events or dealer-specific jackpots, making the system versatile and adaptable to different gameplay scenarios.

### Sequence Diagram Components:

Electronic Table Game Terminals (ETGTs): The terminals where players place their bets and view the growing jackpot pool in real-time. These terminals track player activity and contribute a portion of each bet to the dynamic jackpot.
Live Dealer: Manages the game session and interacts with players, announcing major changes in the jackpot pool size to increase excitement.
Casino Network: A central system that tracks player participation, calculates the contributions to the jackpot pool, and displays updates across all terminals.
Jackpot Server: Manages the overall jackpot pool and ensures that the contributions from all active players are aggregated and reflected in the pool size. It also triggers jackpot payouts when specific conditions are met.
Player A, Player B, Player C: Multiple players who participate by placing bets during the active session. Each player's contributions are tracked, and the growing jackpot pool is displayed on their terminals.
Display System: Shows the current jackpot size in real-time, along with the number of active players contributing to the pool. This display may be integrated into each ETGT or appear on a larger communal screen at the table.

### Implementation Details:

To implement this concept, the casino network and ETGT systems are configured to monitor player participation and dynamically adjust the jackpot pool based on real-time betting data. Each time a player places a bet, a portion of that wager is contributed to the jackpot pool. The contribution rate may vary depending on the number of players participating within a given timeframe, meaning that during peak activity, the pool size increases more rapidly. The growing jackpot amount is displayed in real-time on each player's terminal, creating a sense of urgency and excitement.

The dynamic nature of the pooling system ensures that the jackpot pool is always proportional to player engagement, making it more appealing to join during busy periods. This implementation encourages players to place more bets or continue playing longer, knowing that their contributions are making a noticeable impact on the jackpot pool size.

This feature is particularly beneficial for live dealer DETG systems, where social interaction and competition are notable elements of the gameplay. By displaying the increasing jackpot in real-time, the system fosters a sense of shared excitement and competition among players.

### Example Walk-Through Scenario:

Imagine a scenario at a live dealer blackjack table where 10 players are actively participating. Player A places a bet, and a portion of that bet is added to the dynamic jackpot pool. As other players, including Players B and C, continue placing their wagers, the jackpot pool begins to grow. The ETGTs display the real-time growth of the pool, showing each player how their contributions are influencing the total jackpot amount.

As the session progresses, more players join the game, and the rate at which the jackpot grows increases. Player C notices the pool size rapidly increasing and decides to place higher bets, hoping to trigger the jackpot before the end of the session. The excitement builds as the dealer announces the growing jackpot amount, and all players keep an eye on the communal display.

Eventually, Player A hits a qualifying game outcome, triggering the jackpot. The dynamic jackpot pool, which has significantly increased due to the high level of participation, is awarded to Player A. The ETGTs show the final payout, and the system resets the pool for the next round.

### Player Interaction:

Players interact with the dynamic jackpot system primarily through their ETGTs. The real-time display of the growing jackpot pool encourages players to increase their bets or continue playing as they see the impact their participation has on the total pool size. This interaction is different from traditional jackpot systems, where the pool grows at a fixed rate. The dynamic nature of this system adds an element of strategy, as players may anticipate when the jackpot is to grow quickly based on player volume.

This concept incentivizes players to join during peak times, knowing that higher participation rates lead to faster jackpot growth. The real-time feedback keeps players engaged, as they may visually see how their bets are contributing to the jackpot.

### Distinguishing Innovative Concepts:

The main innovation of this concept is the dynamic nature of the jackpot pool, which grows based on real-time player participation. Unlike conventional ETGT jackpot systems, which rely on fixed contribution rates or random triggers, this system adjusts the jackpot pool size in response to the number of active players and their bet amounts. This creates a more engaging and interactive experience for players, as they may influence the jackpot's growth through their own actions.

Additionally, the system is designed to capitalize on player psychology by increasing the jackpot pool more rapidly during periods of high activity, encouraging further participation. This approach contrasts with static or pre-set jackpots, which do not adapt to real-time conditions.

### Distinguishing Inventive Steps:

1. Real-Time Player Participation Tracking: The system tracks the number of active players and their contributions in real-time, adjusting the jackpot pool dynamically.
2. Variable Jackpot Growth Rate: The jackpot pool grows at different rates depending on the level of player participation, incentivizing players to join during peak times.
3. Real-Time Display and Feedback: The system provides immediate feedback to players, showing how their bets are contributing to the growing jackpot pool and creating a sense of shared excitement.

These steps distinguish this concept from traditional progressive jackpots, which do not offer the same level of interactivity or dynamic growth.

### 35 USC 101 Considerations:

The technical implementation of Dynamic Jackpot Pooling offers a clear improvement over existing jackpot systems by introducing real-time tracking and dynamic pool growth based on player participation. This system provides a concrete solution to the problem of maintaining player engagement during gameplay by allowing players to see the immediate effects of their contributions on the jackpot pool size.

This innovative concept goes beyond an abstract idea by integrating player data, real-time feedback, and dynamic jackpot adjustments into a cohesive system that enhances the overall gaming experience. The system's reliance on real-time data processing and adaptive jackpot growth creates a practical application that improves the functionality of DETGs.

### Data Input:

Players input their bets through their ETGTs, and the system tracks the timing, amount, and frequency of each bet in real-time. This data is used to calculate contributions to the dynamic jackpot pool, which grows at a variable rate depending on player participation.

### Component Interactions and Procedural Steps:

1. Player Bets and Contributions: Each player's bet is processed, and a portion is allocated to the dynamic jackpot pool.
2. Real-Time Pool Growth: The casino network tracks the number of active players and dynamically adjusts the growth rate of the jackpot pool based on participation.
3. Display Updates: The system updates the jackpot display in real-time, showing the current pool size and the number of contributing players.

### Data Processing:

The system processes player data in real-time, calculating the contributions to the jackpot pool and adjusting the growth rate based on player activity. The system also manages the conditions for jackpot triggers and handles the distribution of winnings when the jackpot is awarded.

### Outputs and Responses:

The primary output is the real-time display of the growing jackpot pool, which is shown on each ETGT and a central display at the table. The system also provides notifications when the jackpot is triggered and displays the final payout.

### Data Storage and Reporting:

The system stores all player data, including bets and contributions to the jackpot pool. This data is used for auditing purposes and ensures transparency in the jackpot process.

### Error Handling and Security Measures:

Error handling mechanisms ensure that all contributions are accurately tracked and that the dynamic pool size reflects real-time player participation. Security measures are in place to prevent tampering with the jackpot pool or player contributions.

### End of Interaction:

Once the jackpot is triggered, the system processes the payout and resets the pool for the next round. Players are notified of the final pool size and the jackpot winner, and the system prepares for the next session of dynamic jackpot pooling.

### Innovative Concept 48—Jackpot Prediction System for Players

### Identification of Concept:

This innovative concept involves a jackpot prediction system integrated into Dealer-controlled Electronic Table Games (DETGs), designed to provide players with predictions or probabilities regarding when the mystery jackpot may trigger. The system uses historical data, such as past jackpot triggers, betting patterns, and player activity, to calculate and present predictions about the likelihood of an upcoming jackpot. These predictions are displayed in real-time on each player's Electronic Table Game Terminal (ETGT), offering insight into jackpot trends without guaranteeing exact outcomes. This adds an element of excitement as players may strategize their gameplay based on the provided probabilities, enhancing engagement and fostering longer gameplay sessions.

The concept introduces data-driven insights to players, making them feel more in control of their gaming experience. While the system does not directly influence the randomness of the jackpot, the predictive model adds an entertaining layer of speculation and informed decision-making for players.

### Sequence Diagram Components:

Electronic Table Game Terminals (ETGTs): Display real-time jackpot prediction data, providing players with probabilities or likelihood estimates of upcoming jackpots based on historical trends.
Casino Network: Collects historical game data, including jackpot triggers, player betting behaviors, and gameplay metrics. It provides this data to the jackpot prediction system for analysis and probability generation.
Jackpot Server: Uses algorithms to process historical data and generate predictions about upcoming jackpot triggers, distributing this data to ETGTs in real-time.
Players A, B, C: Players who interact with the prediction system through their ETGTs, adjusting their strategies based on the displayed predictions.
Prediction Algorithm: A backend system that processes historical data, analyzing past jackpot patterns and player activities to estimate probabilities of future jackpot events.

### Implementation Details:

The prediction system is implemented by integrating a dedicated algorithm within the casino network that continuously analyzes historical data from all DETGs. The prediction algorithm evaluates patterns such as the frequency of jackpot triggers, player behavior (betting amounts, session lengths), and previous jackpot payouts. This information is processed to generate a probability score, which is displayed on each ETGT.

The system may present these predictions in various ways. For example, it may display a percentage chance of the jackpot being triggered in the next round or offer a countdown based on historical trends, indicating that a jackpot is “due” within a certain number of game rounds. Players receive real-time updates on these probabilities, allowing them to adjust their betting strategies accordingly.

The predictions add an additional layer of excitement without altering the randomness of the jackpot. By offering insights into potential trends, players are more to remain engaged, waiting for a high-probability event to occur.

### Example Walk-Through Scenario:

Player A is engaged in a live dealer-controlled blackjack game at a DETG. During the session, the ETGT displays a prediction stating there is a 40% chance of the mystery jackpot triggering within the next five game rounds. Based on this prediction, Player A decides to increase their bet, hoping to capitalize on the jackpot.

At the same time, Player B, playing roulette, receives a different prediction, indicating that there is a 60% chance the jackpot will trigger after 10 rounds. Player B chooses to place smaller bets, waiting for the probability to increase further. The system continues to update both players with real-time predictions based on ongoing gameplay data, heightening the anticipation.

Eventually, Player A hits the jackpot, confirming the prediction system's relevance and encouraging Player B to keep playing as their own probability increases.

### Player Interaction:

Players interact with the prediction system by monitoring the real-time data displayed on their ETGTs. The predictions do not affect the gameplay directly but provide players with additional information to strategize their wagers. Players may choose to adjust their betting amounts, increase playtime, or wait for better odds based on the predictions provided by the system.

This interaction keeps players engaged for longer periods, as they feel informed and involved in a more strategic gaming experience. The dynamic nature of the predictions ensures that players constantly receive updated information, keeping the gameplay fresh and exciting.

### Distinguishing Innovative Concepts:

This system introduces a data-driven prediction feature to DETGs, differentiating itself from conventional jackpot models where players rely solely on chance. By offering predictions based on historical data, the system provides a unique form of engagement, allowing players to feel more in control of their gaming decisions.

The dynamic, real-time nature of the predictions ensures that the gameplay remains exciting and unpredictable, while the data-driven insights offer players an added layer of strategy. This concept leverages existing data from casino networks to enhance player engagement without altering the fundamental randomness of the jackpot.

### Distinguishing Inventive Steps:

1. Data-Driven Jackpot Predictions: The system generates real-time predictions based on historical jackpot triggers and player activity, offering players insights into potential future jackpot events.
2. Real-Time Feedback to Players: The system continuously updates players with real-time probabilities, ensuring they are always aware of the likelihood of a jackpot trigger.
3. Strategic Player Engagement: Players may use the predictions to adjust their gameplay strategies, making more informed decisions about their wagers and session lengths.

These steps introduce a novel way of enhancing player engagement through data-driven insights, differentiating this system from traditional, purely chance-based jackpot models.

### 35 USC 101 Considerations:

This innovative concept provides a concrete improvement over traditional jackpot systems by introducing a data-driven prediction system that enhances player engagement. The system solves the problem of static, random jackpot triggers by offering players actionable insights based on historical data, creating a more interactive and strategic gaming experience.

The use of historical data and real-time updates provides a tangible improvement in the functionality of DETG systems, integrating practical applications that enhance player engagement without altering the randomness of the jackpot trigger. This system represents a novel, patent-eligible advancement in gaming technology.

### Data Input:

The system collects data from various sources, including historical jackpot triggers, player wagers, session lengths, and game outcomes. This data is processed by the prediction algorithm to generate real-time predictions about potential jackpot events.

### Component Interactions and Procedural Steps:

1. Data Collection: The system collects and analyzes historical game data, including past jackpot triggers and player activities, to create a dataset for predictions.
2. Prediction Generation: The prediction algorithm processes the data and generates real-time predictions, providing players with probability estimates for upcoming jackpot events.
3. Real-Time Updates: Players receive continuous updates on the jackpot predictions through their ETGTs, allowing them to adjust their strategies accordingly.

### Data Processing:

The system processes historical game data and ongoing player activity to generate real-time predictions. The prediction algorithm continuously updates based on new data, ensuring that players receive the most accurate probabilities possible for upcoming jackpot events.

### Outputs and Responses:

The primary output is the real-time display of jackpot predictions on the ETGTs. Players are informed of the likelihood of a jackpot trigger, with dynamic updates provided based on ongoing gameplay and historical trends.

### Data Storage and Reporting:

The system stores historical data on jackpot triggers, player activities, and prediction accuracy for future analysis and refinement. This data may be used to improve the prediction algorithm over time, ensuring more accurate and engaging predictions for players.

### Error Handling and Security Measures:

Error handling mechanisms ensure that the prediction system functions accurately, with safeguards in place to prevent incorrect predictions or data misinterpretation. Security measures protect the integrity of the historical data and ensure that predictions are based on accurate, unmanipulated information.

### End of Interaction:

Once a jackpot is triggered, the system resets the predictions and begins analyzing new data for future predictions. Players are informed of the jackpot outcome, and the prediction system continues to update based on ongoing gameplay.

### Innovative Concept 49—VIP-Exclusive Jackpot Activation Windows

### Identification of Concept:

The VIP-Exclusive Jackpot Activation Windows concept introduces specific time windows where jackpot opportunities are available only to VIP players or players who meet specific criteria. These exclusive windows may be triggered during particular periods, such as high-stakes promotional events, or personalized for individual players based on their loyalty status or betting behavior. VIP players who meet these criteria may access enhanced jackpot odds, increased payouts, or unique jackpot pools during these limited windows.

The system is designed to reward VIPs or frequent players with personalized experiences, offering an added layer of exclusivity and engagement. This feature incentivizes higher-tier players to continue participating in DETGs (Dealer-controlled Electronic Table Games) during these activation periods, increasing their chances of winning a more significant jackpot.

### Sequence Diagram Components:

Electronic Table Game Terminals (ETGTs): These terminals notify VIP players of upcoming or active jackpot activation windows, showing real-time countdowns, enhanced jackpot odds, or specific conditions available exclusively to eligible players.
Casino Network: Manages player data, including tracking VIP status, play frequency, and other qualifying criteria for jackpot activation windows. It ensures that only eligible players receive notifications of these opportunities.
Jackpot Server: Dynamically adjusts jackpot conditions, such as payout amounts or trigger probabilities, during the exclusive activation windows for VIP players.
VIP Player A, VIP Player B: Players with VIP status or qualifying characteristics, eligible for these exclusive jackpot windows. They may participate in enhanced jackpot opportunities not available to non-VIP players.
Eligibility Tracker: A backend system component that tracks player status, determining which players qualify for VIP-exclusive jackpots based on real-time criteria such as play frequency, bet size, or loyalty tier.

### Implementation Details:

The system continuously tracks player activity and assigns VIP status to players based on their loyalty level, total wagers, or participation in specific events. When a player qualifies for VIP status, they become eligible for exclusive jackpot windows, where enhanced jackpots or unique rewards are made available.

The casino network ensures that only qualifying players may access these windows. Once an exclusive jackpot window is triggered, VIP players are notified via their ETGTs, and they have a limited time to participate. During these windows, the jackpot server dynamically adjusts the odds and pool sizes to offer enhanced rewards, ensuring that VIP players receive increased value for their participation.

The system may also create personalized jackpot windows based on a player's history, offering exclusive opportunities tailored to their gameplay patterns. For instance, a high-roller who frequently plays during off-peak hours may receive a personalized jackpot activation window during that time, with enhanced odds or payouts.

### Example Walk-Through Scenario:

Player A, a VIP baccarat player, logs into their ETGT and receives a notification that a special jackpot activation window has been triggered exclusively for VIP players. The system informs Player A that for the next 30 minutes, they will have access to increased jackpot odds and a higher payout multiplier if they trigger the mystery jackpot.

Meanwhile, Player B, who is also a VIP but playing roulette, receives a similar notification, customized for their game. Both players are incentivized to continue playing during this window, knowing that their chances of winning a larger jackpot are significantly higher during the activation period.

At the end of the window, Player A successfully triggers the enhanced jackpot, winning a much larger prize than they would have during normal play.

### Player Interaction:

Players interact with the VIP-exclusive windows through their ETGTs, which notify them of upcoming or active jackpot opportunities. The terminals display countdowns to these exclusive events and provide real-time updates on the enhanced jackpot conditions, such as improved odds or increased payout multipliers.

This feature offers an exciting opportunity for VIP players to participate in time-sensitive jackpot events that reward their loyalty or high-stakes play. The real-time notifications and personalized nature of the activation windows keep players engaged, encouraging them to stay active during these periods to maximize their chances of winning.

### Distinguishing Innovative Concepts:

This concept distinguishes itself by offering personalized, time-limited jackpot opportunities that are available only to VIP players. Unlike conventional jackpot systems, which apply uniformly to all players, this system tailors exclusive windows to high-tier players, creating a more customized and rewarding gaming experience.

The concept's real-time nature, combined with player-specific rewards, adds a layer of excitement and exclusivity to the DETG system, ensuring that VIP players feel valued and motivated to continue their participation.

### Distinguishing Inventive Steps:

1. Exclusive VIP Jackpot Windows: The system creates time-sensitive jackpot windows available only to VIP players, offering enhanced odds and payout multipliers during these periods.
2. Real-Time Notification and Feedback: VIP players receive real-time notifications of upcoming or active jackpot windows, ensuring that they are aware of and may take advantage of these opportunities.
3. Dynamic Jackpot Adjustment: The jackpot server dynamically adjusts jackpot odds and payout conditions during these VIP windows, providing personalized rewards that enhance the gaming experience.

These steps distinguish this system from traditional jackpot models by offering exclusive opportunities tailored specifically to high-tier players, creating a more personalized and engaging experience.

### 35 USC 101 Considerations:

This innovative concept provides a specific and concrete improvement over traditional jackpot systems by introducing VIP-exclusive activation windows, which offer tailored rewards to high-tier players. The system solves the problem of static, one-size-fits-all jackpot conditions by personalizing jackpot opportunities based on player status.

This technical solution goes beyond abstract concepts by dynamically adjusting jackpot odds and conditions during real-time VIP windows. The use of personalized activation windows represents a novel and patent-eligible advancement in gaming technology, providing a tangible improvement to player engagement and satisfaction.

### Data Input:

The system collects data on player status, including loyalty level, wager history, and participation frequency. VIP players input their participation through normal gameplay during the activation window, which triggers the enhanced jackpot conditions.

### Component Interactions and Procedural Steps:

1. Eligibility Tracking: The system tracks player status and determines which players qualify for VIP-exclusive jackpot windows based on real-time criteria.
2. Jackpot Window Activation: When the system triggers a jackpot window, VIP players are notified through their ETGTs, and the jackpot server adjusts the odds and payout conditions.
3. Jackpot Distribution: If a player triggers the jackpot during the window, the system calculates the enhanced payout and distributes it accordingly.

### Data Processing:

The system processes real-time player data to determine eligibility for VIP jackpot windows. It adjusts the jackpot odds and payouts dynamically, ensuring that VIP players receive enhanced rewards during the activation periods.

### Outputs and Responses:

The primary output is the notification provided to VIP players through their ETGTs, informing them of active or upcoming jackpot windows. The system also dynamically adjusts the jackpot odds and payouts, ensuring that VIP players receive enhanced rewards during the window.

### Data Storage and Reporting:

The system stores data on player eligibility, jackpot windows, and payout distributions for reporting and auditing purposes. This data is used to track VIP engagement and evaluate the effectiveness of the exclusive jackpot windows.

### Error Handling and Security Measures:

Error handling ensures that VIP players receive the correct jackpot odds and payouts during the activation windows. Security measures protect the integrity of the VIP-exclusive system, ensuring that only eligible players may participate and preventing manipulation of player status.

### End of Interaction:

Once the VIP-exclusive window ends, the system resets the enhanced jackpot conditions and resumes normal play. Players are notified of the final results, and the system continues tracking player status for future VIP opportunities.

### Innovative Concept 50—Progressive Jackpot Contribution for Specific Hands

### Identification of Concept:

This innovative concept introduces a system where specific game hands contribute additional amounts to a progressive jackpot pool. For example, in games like blackjack or baccarat, achieving predefined special hands such as a “Royal Flush” or “Blackjack” may trigger a bonus contribution to the jackpot pool. This encourages players to aim for specific outcomes that not only improve their chances of winning the game but also contribute to a shared jackpot, making the overall gameplay more exciting.

This concept integrates seamlessly into live dealer-controlled DETGs by associating certain outcomes with increased jackpot contributions, enhancing the competitive spirit among players. As more players contribute to the jackpot, the potential reward increases, incentivizing players to stay at the table longer and strive for these specific hands.

### Sequence Diagram Components:

Electronic Table Game Terminals (ETGTs): Each player's terminal tracks individual game outcomes and contributes a portion of special hands to the progressive jackpot.
Live Dealer: Facilitates the game and announces when special hands contribute additional amounts to the progressive jackpot pool.
Casino Network: Manages the progressive jackpot pool, including contributions from special hands, and updates the current jackpot amount in real-time across all terminals.
Jackpot Server: Handles the processing of special hand outcomes and the progressive jackpot contributions.
Players A, B, and C: The players participating in the game, who contribute to the jackpot pool through regular gameplay and specific hand triggers.
Jackpot Display System: Displays the growing jackpot pool and announces when special hand contributions are made.

### Implementation Details:

To implement this system, each ETGT is configured to detect when a player achieves one of the predefined special hands, such as a Blackjack or Royal Flush. When a player hits such a hand, the system automatically triggers an additional contribution to the progressive jackpot pool, which is then updated in real-time. The contributions may be a fixed percentage of the player's winnings or a set amount defined by the casino.

The implementation also involves tracking these special hand outcomes across multiple terminals, ensuring that all qualifying hands are recognized. The casino network then communicates with the jackpot server, which updates the jackpot display on all terminals in real-time. This approach encourages players to aim for these specific outcomes, knowing their efforts will not only benefit them but also contribute to a shared reward.

This system differs from standard progressive jackpots, which typically only grow based on overall betting contributions. By associating specific hands with additional contributions, the system introduces a new layer of strategy and excitement, as players will seek out these special hands to boost the jackpot.

### Example Walk-Through Scenario:

Imagine a scenario at a live dealer-controlled blackjack table where Player A is dealt an Ace and a 10, achieving a Blackjack. The system automatically recognizes this special hand and contributes an additional $50 to the progressive jackpot pool. The contribution is immediately reflected on the jackpot display, which shows an updated total.

Meanwhile, Player B, sitting at the same table, notices the increase in the jackpot and decides to increase their bet in hopes of achieving a special hand that would trigger another contribution. Player C, who is also engaged in the game, is motivated to stay longer, hoping to both win the game and contribute to the growing jackpot.

The live dealer announces the special hand contribution, further enhancing the excitement around the table. All players may see the updated jackpot amount and are motivated to continue playing, knowing that their contributions may significantly impact the pool.

### Player Interaction:

Players interact with this innovative concept through their ETGTs. The system tracks their game outcomes, particularly focusing on special hands that trigger additional contributions to the progressive jackpot. Players are motivated to aim for these hands, knowing they may directly influence the jackpot pool's growth.

This interaction is more engaging compared to traditional progressive jackpots, where contributions are based solely on bets. Here, players have an additional incentive to achieve specific outcomes, adding strategic depth to their gameplay. The real-time display of the growing jackpot encourages players to remain engaged and seek out these special hands.

### Distinguishing Innovative Concepts:

The primary innovation of this concept is the tie between specific game hands and contributions to the progressive jackpot. This approach creates an additional layer of excitement and strategy for players, who are incentivized to aim for specific hands that not only improve their game performance but also increase the shared jackpot pool.

Unlike traditional progressive jackpots, which grow based solely on bet amounts, this system introduces a dynamic element by linking special hands to jackpot contributions. This keeps players engaged and encourages them to participate longer, knowing they have a chance to influence the jackpot's growth through their gameplay.

### Distinguishing Inventive Steps:

1. Automatic Contribution on Special Hands: The system detects when a player achieves a special hand and automatically contributes an additional amount to the jackpot pool.
2. Real-Time Jackpot Display Updates: The progressive jackpot pool is updated in real-time whenever a special hand contribution is made, keeping players informed and engaged.
3. Special Hand Incentives: By linking special hands to jackpot contributions, the system adds a strategic element to gameplay, encouraging players to aim for these hands to boost the jackpot pool.

These steps differentiate this system from conventional progressive jackpots, which rely solely on betting contributions. By tying contributions to game outcomes, the system enhances player engagement and creates a more dynamic and exciting gaming experience.

### 35 USC 101 Considerations:

This innovative concept clearly addresses the technical problem of enhancing player engagement and jackpot participation in live dealer-controlled DETGs. By linking specific game outcomes to progressive jackpot contributions, the system provides a practical improvement over existing progressive jackpots, which are typically static in their growth mechanisms.

This system integrates real-time data processing, game outcome detection, and dynamic jackpot adjustments, offering a concrete solution that improves the functionality of live gaming systems. The use of specific hand triggers introduces a new layer of engagement, making the system a patent-eligible improvement to traditional gaming technology.

### Data Input:

Players input their bets and participate in the game as usual. The system monitors game outcomes, particularly focusing on special hands, and uses this data to calculate contributions to the progressive jackpot pool. Each special hand automatically triggers a contribution to the jackpot, which is processed in real-time.

### Component Interactions and Procedural Steps:

1. Player Bets and Special Hand Detection: The system tracks each player's bets and game outcomes, focusing on predefined special hands that trigger additional jackpot contributions.
2. Automatic Jackpot Contribution: When a player achieves a special hand, the system automatically contributes a set amount or percentage to the jackpot pool.
3. Real-Time Jackpot Display Update: The system updates the jackpot display in real-time, reflecting the new pool size and keeping all players informed.

### Data Processing:

The system processes real-time data from player gameplay, focusing on special hands that contribute to the progressive jackpot pool. The data is transmitted to the jackpot server, which updates the pool amount and displays the new total on each ETGT. The system also handles the distribution of winnings when the jackpot is triggered.

### Outputs and Responses:

The primary output is the real-time update of the jackpot pool, displayed on each ETGT and a central display at the table. The system also provides notifications when a special hand is achieved and contributes to the jackpot, ensuring that all players are aware of the growing pool.

### Data Storage and Reporting:

The system stores data related to player outcomes, special hand contributions, and jackpot triggers. This data is used for auditing purposes and ensures transparency in the progressive jackpot process.

### Error Handling and Security Measures:

The system includes error handling mechanisms to ensure that special hand contributions are accurately tracked and reflected in the jackpot pool. Security measures are in place to prevent tampering with jackpot contributions or game outcomes.

### End of Interaction:

Once the jackpot is triggered, the system processes the payout and resets the pool for the next round. Players are notified of the final jackpot amount and the winner, and the system prepares for the next session.

### Innovative Concept 56—Mystery Jackpot Tied to Specific Dealer Actions or Behaviors

### Identification of Concept:

This innovative concept introduces a mystery jackpot feature tied to specific actions or behaviors of the live dealer in a multiplayer DETG environment. Rather than jackpots being solely linked to random triggers or player performance, the system dynamically reacts to specific dealer activities during gameplay. For example, the mystery jackpot may be triggered when the dealer hits a series of specific win conditions (e.g., winning multiple rounds consecutively) or performs certain behaviors (e.g., a “dealer bonus round”). This integration of dealer actions into jackpot mechanics not only increases player engagement but also adds an unpredictable and exciting element to the game, as players anticipate the dealer's behavior influencing their potential winnings.

This feature enhances the live dealer environment by making the dealer an active participant in the mystery jackpot system. Players are incentivized to pay close attention to the dealer's actions, heightening the overall excitement and interaction between the dealer and the players.

### Sequence Diagram Components:

Electronic Table Game Terminals (ETGTs): The terminals where players place bets, view the game progress, and are notified when dealer-related jackpot events are triggered.
Live Dealer: The central actor in this system, whose actions or game outcomes (such as consecutive wins or reaching a specific threshold) are linked to the activation of the mystery jackpot.
Casino Network: Tracks the dealer's performance and communicates with the jackpot server to determine when dealer-triggered conditions are met.
Jackpot Server: Processes the conditions related to the dealer's performance and triggers the mystery jackpot when the specified actions or behaviors occur.
Player A, Player B, Player C: Multiple players participating in the game who are impacted by the dealer's actions and contribute to the jackpot pool. Each player may win or benefit when dealer-triggered jackpots are activated.
Central Jackpot Display: Shows the current status of the mystery jackpot pool and notifies players when dealer actions result in a jackpot trigger.

### Implementation Details:

The system tracks and monitors specific dealer actions or behaviors throughout each game session. For example, it may track how many consecutive rounds the dealer wins, or whether the dealer meets a specific milestone such as dealing a certain number of blackjack hands. These conditions are predefined and configured into the casino network and jackpot server. When the dealer achieves one of these conditions, the system triggers the mystery jackpot, and a portion of the jackpot pool is awarded to the players.

ETGTs are configured to display a running tally of the dealer's progress toward meeting these predefined conditions. Players are continuously updated on how close the dealer is to triggering a jackpot event, which keeps them engaged and aware of the stakes. This implementation may also allow for customizable jackpot rules, such as increasing jackpot contributions based on dealer streaks or randomly activating jackpot multipliers when the dealer meets certain performance thresholds.

This system offers a distinct improvement over traditional mystery jackpot mechanisms, as the inclusion of dealer actions adds an additional layer of unpredictability and excitement to the game.

### Example Walk-Through Scenario:

Imagine a scenario at a live dealer-controlled baccarat table. The dealer, over several rounds, wins five consecutive games. As this streak unfolds, the ETGTs alert players that the dealer is nearing a potential mystery jackpot trigger. The jackpot server is set to trigger the mystery jackpot if the dealer wins six consecutive rounds.

As the next round is dealt, tension builds among the players. The dealer wins the sixth consecutive game, triggering the mystery jackpot. The system immediately notifies all players that the jackpot has been activated, and a portion of the jackpot pool is awarded to the participants.

Player A, who had placed a significant wager on the round, wins a larger share of the jackpot pool, while Players B and C, who placed smaller bets, also receive a portion of the prize. The shared excitement and anticipation of the dealer's streak added to the overall engagement at the table.

### Player Interaction:

Players interact with the system primarily through their ETGTs. The terminals display real-time updates on the dealer's performance and notify players when the dealer is close to triggering a jackpot. This encourages players to remain engaged, as they are now invested not only in their own performance but also in the dealer's actions.

The interaction is more dynamic compared to traditional jackpot systems, as players are incentivized to root for or against the dealer based on how their actions may influence the mystery jackpot. This adds a layer of strategy to the game, as players may adjust their betting behavior based on the dealer's performance streak.

### Distinguishing Innovative Concepts:

This innovative concept distinguishes itself by tying the mystery jackpot to the dealer's actions or behaviors, making the dealer an active participant in the jackpot system. Traditional mystery jackpots are often triggered randomly or based solely on player performance. This system, however, creates a direct link between the dealer's gameplay and the jackpot trigger, enhancing the live, interactive nature of DETG environments.

The inclusion of real-time feedback on the dealer's performance and its impact on the jackpot pool further differentiates this system from conventional methods, fostering a deeper level of player engagement and excitement.

### Distinguishing Inventive Steps:

1. Dealer-Triggered Jackpot Conditions: The system links jackpot triggers to specific dealer actions, such as consecutive wins or achieving a particular game outcome, creating a unique jackpot activation mechanism.
2. Real-Time Player Updates: The system provides real-time feedback on the dealer's progress toward triggering the jackpot, keeping players informed and engaged.
3. Variable Jackpot Contributions: Based on the dealer's performance, the system may adjust the size of jackpot contributions or trigger multipliers, adding a layer of unpredictability to the jackpot system.

These steps distinguish this system from traditional progressive or mystery jackpots, which are typically linked to player bets or random events, rather than dealer actions.

### 35 USC 101 Considerations:

The technical implementation of a dealer-triggered mystery jackpot system provides a specific, concrete improvement to gaming systems by integrating the dealer's actions into the jackpot trigger mechanism. This concept solves the problem of passive dealer involvement in DETGs by actively involving the dealer in jackpot-related outcomes, enhancing the overall gameplay experience.

This system goes beyond abstract ideas by implementing a real-time, interactive process that dynamically adjusts the jackpot based on specific dealer behaviors. The use of real-time tracking, feedback, and dynamic jackpot triggers makes this system a practical improvement over existing methods, providing a patent-eligible advancement in gaming technology.

### Data Input:

The system collects data from each round of gameplay, tracking the dealer's performance (e.g., consecutive wins, specific hands dealt, etc.). This data is then processed to determine when the dealer meets the conditions for triggering a mystery jackpot.

### Component Interactions and Procedural Steps:

1. Dealer Performance Tracking: The system tracks the dealer's actions during each game session and compares them against predefined jackpot conditions.
2. Jackpot Trigger: When the dealer meets the conditions (e.g., winning a set number of consecutive rounds), the system triggers the mystery jackpot.
3. Player Notification: The system updates all ETGTs with the jackpot trigger information and distributes the winnings according to each player's participation.

### Data Processing:

The system processes real-time data related to the dealer's performance, comparing it against predefined conditions for triggering the jackpot. Once a trigger condition is met, the system calculates the distribution of the jackpot pool and updates all connected ETGTs.

### Outputs and Responses:

The primary output is the notification to all players that the mystery jackpot has been triggered, along with the updated pool amount and the distribution of winnings. Players are notified on their ETGTs, and the dealer may also announce the event to increase excitement.

### Data Storage and Reporting:

The system stores data related to dealer performance, jackpot triggers, and player participation. This data is used for auditing purposes and to track the overall performance of the dealer-triggered mystery jackpot system.

### Error Handling and Security Measures:

Error handling ensures that dealer performance is accurately tracked and that jackpot triggers are processed correctly. Security measures are in place to prevent tampering with the dealer's performance data or jackpot conditions.

### End of Interaction:

Once the jackpot is triggered and the winnings are distributed, the system resets for the next game session. Players are notified of the final results, and the system prepares for the next opportunity for dealer-triggered jackpot events.

### Innovative Concept 51—Dynamic Jackpot Trigger Criteria Based on Real-Time Player Engagement Metrics

### Identification of Concept:

This innovative concept introduces a dynamic system where jackpot triggers are adjusted based on real-time player engagement metrics across networked DETGs (Dealer-controlled Electronic Table Game systems). The system continuously monitors player behavior—such as bet amounts, frequency of play, number of active players, and session durations—and uses this data to automatically modify the criteria for triggering a jackpot. For example, if player engagement is high, the system may increase the threshold required to trigger a jackpot, creating a larger potential payout. Conversely, during low engagement periods, the system may reduce the trigger criteria, making it easier to activate the jackpot and encouraging players to stay engaged.

This concept allows casinos to optimize jackpot timing based on live player activity, ensuring that jackpots are triggered in ways that maximize excitement and player retention. By adjusting the criteria dynamically, the system enhances the overall gaming experience, keeping players more invested and preventing stagnation during slower periods.

### Sequence Diagram Components:

Electronic Table Game Terminals (ETGTs): These terminals display real-time updates to the jackpot trigger criteria based on player engagement. They track each player's bets, session length, and activity level, transmitting this data to the casino network.
Live Dealer: Oversees the game session and interacts with the players, but the jackpot criteria are adjusted automatically by the system based on engagement metrics.
Casino Network: Continuously monitors engagement data across all DETGs in the casino, processing metrics such as bet frequency, player count, and total wager amounts to adjust the jackpot trigger criteria dynamically.
Jackpot Server: Receives engagement metrics from the casino network and calculates adjustments to the jackpot trigger criteria. It ensures that these adjustments are reflected in the jackpot displays across the network.
Players A, B, C: Players engaged in the game at networked DETGs. Their activity levels directly influence the system's dynamic adjustment of the jackpot trigger criteria.
Engagement Metrics Processor: A backend system that analyzes real-time player activity across the network and determines when and how to adjust jackpot criteria based on predefined algorithms.

### Implementation Details:

The system monitors a variety of player engagement metrics, including bet amounts, session durations, the number of active players, and bet frequency. This data is collected from ETGTs and transmitted to the casino network, where the engagement metrics processor analyzes the information in real time. Based on these metrics, the jackpot server adjusts the criteria required to trigger a jackpot.

For example, if player activity is high, the system may increase the number of bets required to trigger the jackpot or raise the minimum bet threshold. Alternatively, if player activity is low, the system may lower the trigger criteria to encourage players to remain active and increase the likelihood of a jackpot payout. These adjustments are automatically reflected on the jackpot display, keeping players informed of the current trigger conditions.

This system offers significant benefits compared to traditional fixed jackpot triggers, which remain static regardless of player activity. By dynamically adjusting the criteria, the system creates a more interactive and responsive gaming environment that adapts to real-time player behavior.

### Example Walk-Through Scenario:

Imagine a scenario at a live dealer-controlled blackjack table. Players A, B, and C are actively participating, with their ETGTs displaying a real-time tracker for the current jackpot pool. As the game progresses, the casino network detects that more players are joining the game, and the average bet size is increasing.

The engagement metrics processor recognizes the heightened activity and adjusts the jackpot trigger criteria. Previously, the jackpot required 200 cumulative bets to trigger, but due to the increase in player engagement, the system raises the threshold to 300 bets, creating the potential for a larger payout. Players see the updated trigger criteria on their ETGT displays and are encouraged to place more bets, knowing that the jackpot pool is growing faster with increased activity.

Later, during a slower period, the system detects a drop in player engagement and reduces the trigger threshold to 150 cumulative bets, making it easier for the remaining players to activate the jackpot. Player C, who had been planning to leave, notices the lower trigger criteria and decides to stay in the game longer, hoping to trigger the jackpot sooner.

### Player Interaction:

Players interact with this system through their ETGTs, which display the current jackpot pool and the dynamically adjusted trigger criteria. As the criteria change based on player engagement, players are notified in real-time, allowing them to adjust their strategies accordingly. For example, players may choose to increase their bet amounts or play more frequently when they see that the jackpot trigger criteria have been adjusted due to heightened engagement.

This dynamic interaction keeps players engaged, as they are not only playing against the dealer but also contributing to a collective effort to trigger the jackpot. The real-time feedback creates a sense of competition and collaboration, as players work together to meet the trigger criteria.

### Distinguishing Innovative Concepts:

The notable innovation in this concept is the use of real-time player engagement metrics to adjust jackpot trigger criteria dynamically. Unlike conventional jackpots that rely on static thresholds, this system continuously adapts to the current level of player activity. This ensures that jackpots are triggered at optimal times, either to capitalize on high engagement or to incentivize players during slower periods.

The system's ability to adjust criteria in real-time creates a more responsive and interactive gaming experience, encouraging players to stay longer and remain more invested in the game.

### Distinguishing Inventive Steps:

1. Real-Time Player Engagement Monitoring: The system continuously collects and analyzes data on player activity, including bet amounts, session duration, and the number of active players.
2. Dynamic Adjustment of Jackpot Trigger Criteria: Based on the real-time engagement data, the system automatically adjusts the criteria required to trigger a jackpot, such as increasing or decreasing the number of cumulative bets or raising the minimum bet threshold.
3. Player Notification and Feedback: The system provides real-time updates to players on the current jackpot trigger conditions, encouraging them to adjust their betting strategies based on the updated criteria.

These steps distinguish the system from traditional jackpot mechanisms, which rely on fixed criteria and do not adapt to real-time player behavior.

### 35 USC 101 Considerations:

The dynamic jackpot trigger system provides a concrete, technical improvement over existing systems by integrating real-time player engagement metrics to adjust jackpot criteria. This system solves the problem of stagnant or misaligned jackpot triggers by ensuring that the criteria are responsive to live player activity, enhancing both player engagement and the gaming experience.

This system is not an abstract idea but a practical, real-time solution that dynamically adjusts game conditions based on actual player data. The use of real-time engagement metrics and automatic adjustments to jackpot triggers represents a novel, patent-eligible improvement in casino gaming technology.

### Data Input:

The system collects real-time data from player interactions at ETGTs, including bet sizes, session length, and player participation levels. This data is transmitted to the casino network for processing by the engagement metrics processor.

### Component Interactions and Procedural Steps:

1. Player Activity Monitoring: The system tracks player engagement metrics such as bet frequency, number of active players, and total wager amounts.
2. Criteria Adjustment: The engagement metrics processor analyzes the data and determines when to adjust the jackpot trigger criteria based on predefined algorithms.
3. Player Notification: The system updates the jackpot display on each ETGT, notifying players of any changes to the jackpot trigger conditions in real-time.

### Data Processing:

The system processes real-time engagement data from all networked DETGs, adjusting the jackpot trigger criteria as necessary. The engagement metrics processor continuously evaluates player activity and modifies the trigger thresholds to optimize jackpot timing.

### Outputs and Responses:

The primary output is the real-time update of the jackpot trigger criteria, displayed on each ETGT. Players are notified when the criteria change, allowing them to adjust their gameplay accordingly. The system also updates the jackpot pool based on the new trigger conditions.

### Data Storage and Reporting:

The system stores records of all player engagement metrics, trigger adjustments, and jackpot events. This data is used for auditing purposes and to evaluate the effectiveness of the dynamic trigger system.

### Error Handling and Security Measures:

Error handling mechanisms ensure that player engagement data is accurately collected and that trigger criteria are adjusted correctly. Security measures prevent tampering with the jackpot system or engagement data.

### End of Interaction:

Once the jackpot is triggered, the system processes the payout and resets the trigger criteria for the next session. Players are notified of the final results, and the system adjusts the criteria based on the current level of player engagement.

Innovative Concept 52—Multi-Tiered Mystery Jackpot System with Cascading Triggers

### Identification of Concept:

The Multi-Tiered Mystery Jackpot System introduces a structure where multiple jackpot tiers exist, with players having the opportunity to trigger jackpots at various levels. When a lower-tier jackpot is triggered, the odds of hitting a higher-tier jackpot increase, creating a cascading effect that builds player anticipation and excitement. This concept may be implemented in live dealer-controlled DETGs where multiple players contribute to a shared jackpot pool. Each tier has its own set of criteria for activation, with lower tiers being easier to trigger, but higher tiers offering significantly larger rewards.

This feature not only adds excitement but also keeps players engaged over longer periods as they anticipate the possibility of triggering successively larger jackpots. The cascading effect ensures that each lower-tier win brings players closer to higher-tier prizes, thus increasing the overall appeal and engagement of the game.

### Sequence Diagram Components:

Electronic Table Game Terminals (ETGTs): Players use these terminals to place bets and view the status of the current jackpot tiers. The terminals track player activity and display the progress towards triggering the various jackpot tiers.
Live Dealer: Oversees the game, interacting with players and announcing when jackpots are triggered, particularly when cascading tiers come into play.
Casino Network: Tracks the contributions of players to the various jackpot tiers and adjusts the odds of triggering higher-tier jackpots as lower-tier jackpots are won.
Jackpot Server: Manages the overall jackpot pool, ensuring that funds are allocated to each tier and calculating when cascading triggers should occur.
Players A, B, C: The participants contributing to the jackpot pool and benefiting from the cascading trigger system when a jackpot is won.
Jackpot Display System: Shows the status of each jackpot tier and notifies players when a lower-tier jackpot is triggered, increasing anticipation for higher-tier wins.

### Implementation Details:

This system involves configuring the casino network to monitor player contributions and track when each jackpot tier is close to being triggered. The jackpot server allocates a portion of each bet to different tiers, with higher-tier jackpots receiving a smaller percentage of each bet. When a lower-tier jackpot is triggered, the odds of hitting the next higher tier increase dynamically. The cascading trigger feature ensures that every jackpot win builds player excitement for the possibility of larger wins.

Each ETGT is configured to display the status of the different jackpot tiers, keeping players informed of their progress towards triggering the next jackpot. The system may use real-time feedback to show players how close they are to triggering each tier, fostering engagement and encouraging continued play.

For example, the first tier may require a certain number of collective player bets to trigger, while the second tier may activate when a specific win streak is achieved. The system's flexibility allows casinos to customize the criteria for each tier, adjusting the difficulty based on player behavior and overall engagement.

### Example Walk-Through Scenario:

At a live dealer-controlled roulette table, Player A hits the first-tier jackpot after a series of rounds. The ETGTs immediately notify all players that the first-tier jackpot has been won, and the system dynamically adjusts the odds of triggering the second-tier jackpot. The players see the increased likelihood of hitting the next tier, which encourages them to keep playing.

As the game continues, Player B contributes more significant bets, knowing that the chances of triggering the second-tier jackpot have increased. Eventually, Player C wins the second-tier jackpot, and the system again adjusts the odds for the third and highest tier. This cascading effect builds excitement and drives player engagement, as each win increases the anticipation of a larger prize.

### Player Interaction:

Players interact with this system primarily through their ETGTs, which provide real-time updates on the status of each jackpot tier. As they place bets, the system tracks their contributions to the jackpot pool and displays their progress towards triggering each tier. When a lower-tier jackpot is triggered, players are notified immediately, and the system informs them of the increased odds for higher-tier wins.

This interaction keeps players engaged, as they may see how their bets impact the overall game and how close they are to triggering the next jackpot. The cascading nature of the jackpots ensures that players remain invested in the game over multiple rounds.

### Distinguishing Innovative Concepts:

The main distinguishing feature of this concept is the cascading nature of the jackpot system. Unlike traditional single-tier jackpots, this system offers multiple levels of potential winnings, with each lower-tier win increasing the odds of triggering higher tiers. This approach creates a more engaging and interactive gaming experience, as players are constantly working towards progressively larger prizes.

Additionally, the system's dynamic adjustment of jackpot odds based on player behavior adds a layer of strategy and anticipation that is not present in conventional jackpot systems. By offering multiple tiers with cascading triggers, the system enhances player retention and satisfaction.

### Distinguishing Inventive Steps:

1. Cascading Jackpot Triggers: The system dynamically adjusts the odds of hitting higher-tier jackpots after a lower-tier win, creating a sense of progression and anticipation.
2. Multi-Tier Jackpot Structure: Players contribute to multiple jackpot tiers, with each tier offering progressively larger rewards and requiring different criteria for activation.
3. Real-Time Odds Adjustment: The system provides real-time feedback to players, showing how their contributions impact the odds of triggering each jackpot tier.

These steps differentiate this system from conventional single-tier jackpots, offering a more engaging and interactive experience for players.

### 35 USC 101 Considerations:

This innovative concept offers a clear improvement over existing jackpot systems by introducing a multi-tiered structure with cascading triggers. The system solves the problem of player disengagement by ensuring that each win increases the excitement and anticipation of larger prizes. This real-time adjustment of jackpot odds based on player behavior provides a tangible, technical improvement to the functionality of DETG systems.

By dynamically adjusting the jackpot triggers based on real-time player data, the system goes beyond an abstract idea and integrates a practical application that enhances the overall gaming experience. The cascading nature of the jackpots represents a novel and patent-eligible advancement in casino gaming technology.

### Data Input:

Players input their bets through the ETGTs, contributing to the jackpot pool for each tier. The system tracks these contributions and monitors the criteria for triggering each tier, such as the number of collective bets or specific win conditions.

### Component Interactions and Procedural Steps:

1. Player Contributions: Each player's bet is allocated to the appropriate jackpot tiers, with a portion going to the higher-tier jackpots.
2. Cascading Trigger Activation: When a lower-tier jackpot is triggered, the system dynamically adjusts the odds for the next tier.
3. Player Notification: The system updates all ETGTs in real-time, notifying players of the jackpot trigger and the increased odds for higher-tier wins.

### Data Processing:

The system processes real-time data from player bets, tracking the progress towards triggering each jackpot tier. Once a lower-tier jackpot is won, the system recalculates the odds for the higher tiers and updates the relevant displays on the ETGTs.

### Outputs and Responses:

The primary output is the real-time notification to players when a jackpot is triggered, along with the updated odds for higher-tier jackpots. The system also displays the current progress towards triggering each tier, encouraging continued play.

### Data Storage and Reporting:

The system stores data on player contributions, jackpot triggers, and the odds adjustments for each tier. This data is used for auditing purposes and to ensure transparency in the jackpot distribution process.

### Error Handling and Security Measures:

The system includes error handling mechanisms to ensure that jackpot triggers and odds adjustments are calculated accurately. Security measures prevent tampering with the jackpot system or player contributions.

### End of Interaction:

Once the highest-tier jackpot is triggered, the system resets the tiers and prepares for the next game session. Players are notified of the final jackpot amounts, and the system begins tracking contributions for the next set of cascading jackpots.

### Innovative Concept 53—Player-to-Player Jackpot Gifting System

### Identification of Concept:

The Player-to-Player Jackpot Gifting System introduces a social element to live dealer-controlled multiplayer DETGs, where players who win a jackpot may choose to share a portion of their winnings with other players seated at the table. This feature allows a player to allocate a percentage of their jackpot to other active participants as a gesture of camaraderie or to enhance the social atmosphere of the game. The jackpot gifting option may be available only for certain types of wins, such as progressive or mystery jackpots, and is designed to increase player engagement by fostering a sense of community within the game.

This system may be particularly effective in games with a social component, such as poker or blackjack, where players often develop a rapport with others at the table. By allowing players to share their winnings, casinos may see increased session lengths and player satisfaction, as the overall experience becomes more cooperative and rewarding.

### Sequence Diagram Components:

Electronic Table Game Terminals (ETGTs): Each player's terminal, where jackpot winnings are displayed, and gifting options are provided. The terminal tracks player participation and allows for the allocation of jackpot shares to other players.
Live Dealer: The dealer interacts with players, announcing jackpot wins and facilitating the gifting process if a player chooses to share their winnings.
Casino Network: Manages the transaction of jackpot funds between players, ensuring the correct amounts are transferred to each recipient based on the player's gifting preferences.
Jackpot Server: Calculates the total jackpot amount, processes player gifting choices, and distributes the appropriate shares to the selected players.
Player A (Jackpot Winner): The player who wins the jackpot and has the option to share a portion of their winnings with other players.
Players B, C, D (Recipients): Other players at the table who may receive a portion of the jackpot if selected by Player A.

### Implementation Details:

This innovative concept may be implemented by configuring the ETGTs to display gifting options after a jackpot is won. When Player A wins a jackpot, their terminal prompts them with the option to allocate a percentage of the total winnings to other players at the table. The terminal interface allows Player A to choose the percentage to gift and select specific players to receive the funds.

Once Player A confirms their selections, the casino network processes the transaction, transferring the appropriate amounts from the jackpot pool to the other players' accounts. The gifted players receive notifications on their terminals, indicating the amount they have been gifted and who the funds came from.

The system may be customized to allow players to gift winnings in different ways. For example, Player A may choose to split the jackpot equally among all players or only gift to those who have contributed to the jackpot pool. The implementation ensures that all transfers are secure and that Player A's choices are reflected in real-time.

### Example Walk-Through Scenario:

Imagine a scenario at a live dealer-controlled poker table where Player A hits a mystery jackpot. The total amount of the jackpot is displayed on Player A's ETGT, along with the option to share a portion of the winnings. Player A, feeling generous, decides to allocate 20% of the jackpot to other players at the table.

Player A selects Players B, C, and D as the recipients and confirms their decision on the ETGT. The casino network processes this information, and within seconds, Players B, C, and D see notifications on their ETGTs that they have received a share of the jackpot. The gifted amounts are added to their accounts, and a message from Player A appears, thanking them for their participation in the game.

This scenario not only rewards the winner but also enhances the gaming experience for everyone at the table, creating a sense of shared success and fostering a social connection between the players.

### Player Interaction:

Players interact with this system primarily through their ETGTs, where they may choose to share a portion of their jackpot winnings with others. The gifting system is optional, allowing the jackpot winner to decide whether or not to share their prize. The process is straightforward, with the terminal offering clear instructions on how to allocate funds and which players to select.

Recipients of the jackpot gift experience a sense of inclusion and may feel more engaged in the game, knowing that they may benefit from another player's success. This feature adds a social layer to the traditional competitive atmosphere of casino games, encouraging players to collaborate and celebrate each other's wins.

### Distinguishing Innovative Concepts:

This concept distinguishes itself from conventional jackpot systems by introducing the ability to share winnings among players. Traditional ETGTs and jackpot systems focus solely on individual wins, but this system encourages a more communal experience. By allowing players to gift a portion of their jackpot to others, the system enhances the social dynamics of the game, leading to increased player satisfaction and longer gaming sessions.

Additionally, the gifting system introduces an element of strategy, as players may choose to foster goodwill among their peers, potentially leading to a more enjoyable and engaging game environment.

### Distinguishing Inventive Steps:

1. Jackpot Gifting Option: The system provides the jackpot winner with the option to share a percentage of their winnings with other players, introducing a social and cooperative aspect to the game.
2. Player Selection Interface: The ETGT interface allows the jackpot winner to select specific players to gift portions of their winnings, making the process interactive and personalized.
3. Real-Time Transfer of Funds: The casino network processes the gifting transactions in real-time, ensuring that the recipients receive their funds immediately, enhancing the sense of shared success.

These steps differentiate this system from conventional jackpot mechanisms, where winnings are typically isolated to a single player and do not involve any further interaction or sharing.

### 35 USC 101 Considerations:

This innovative concept offers a clear improvement over traditional jackpot systems by incorporating social interaction and player-driven decisions into the jackpot-winning process. By enabling players to share their winnings with others, the system goes beyond an abstract idea and provides a practical solution to enhancing player engagement in live dealer-controlled DETGs.

This system integrates real-time data processing, secure fund transfers, and personalized player interactions, making it a concrete application that improves the overall gaming experience. The ability to dynamically distribute jackpot winnings introduces a novel and patent-eligible advancement in casino gaming technology.

### Data Input:

Players input their jackpot-sharing preferences through their ETGTs, selecting which players to gift and what percentage of the jackpot to share. This data is transmitted to the casino network, which processes the transactions and updates the relevant accounts.

### Component Interactions and Procedural Steps:

1. Jackpot Win and Gifting Prompt: When Player A wins the jackpot, the system prompts them with the option to share their winnings. Player A selects the percentage and recipients through their ETGT.
2. Transaction Processing: The casino network processes the gifting transactions, transferring the appropriate amounts from the jackpot pool to the selected players' accounts.
3. Notification and Account Update: The recipients receive notifications of their gifted amounts, and their accounts are updated in real-time.

### Data Processing:

The system processes Player A's gifting decisions, calculating the percentage of the jackpot to be shared and distributing the funds accordingly. The data is securely transmitted to the jackpot server and casino network for real-time processing.

### Outputs and Responses:

The primary output is the notification sent to the gifted players, informing them of their jackpot share and updating their account balances. Player A also receives confirmation that the transaction was successful.

### Data Storage and Reporting:

The system stores records of all jackpot gifting transactions, including the percentage shared and the recipients. This data is used for auditing purposes and to ensure transparency in jackpot distribution.

### Error Handling and Security Measures:

Error handling ensures that the correct amounts are transferred to the designated players and that no funds are misallocated. Security measures protect the transaction data and prevent tampering with the jackpot pool.

### End of Interaction:

Once the gifting process is complete, the system resets for the next jackpot event. All players are notified of the final results, and the game continues as normal.

### Innovative Concept 54—Jackpot Contributions Tied to Player Loyalty Tiers

### Identification of Concept:

This innovative concept links jackpot contributions directly to player loyalty tiers, where players in higher loyalty tiers contribute a larger portion of their wagers to the jackpot pool. The system is designed to incentivize regular players by offering them more substantial contributions to the jackpot, giving them a higher stake in the game. Higher-tiered players may see a larger percentage of their bets allocated toward the progressive or mystery jackpots, increasing their chances of winning significant prizes.

This loyalty-based jackpot contribution system may be integrated into live dealer-controlled DETGs (Dealer-controlled Electronic Table Game systems) and may adjust dynamically as players advance in their loyalty status. It offers both increased retention for the casino by rewarding regular play and enhanced engagement for players who value their loyalty status.

### Sequence Diagram Components:

Electronic Table Game Terminals (ETGTs): These terminals display information about the player's loyalty tier and how much of their wager contributes to the jackpot pool.
Casino Network: Manages player loyalty accounts, tracking playtime, wager amounts, and automatically adjusting jackpot contribution rates based on the player's loyalty tier.
Loyalty Tier Management Server: Tracks each player's loyalty status and integrates this information into the game system, ensuring that higher-tier players contribute larger amounts to the jackpot pool.
Jackpot Server: Handles contributions from players based on loyalty status, ensuring that higher-tier players' contributions are proportionally larger.
Player A (VIP Tier), Player B (Intermediate Tier), Player C (Entry-Level): Players who contribute varying percentages of their bets to the jackpot pool based on their loyalty tiers.
Jackpot Display: Displays current jackpot amounts and notifies players about their individual contribution levels based on loyalty tier.

### Implementation Details:

This concept may be implemented by linking the player loyalty program directly to the DETG system. Each player is assigned a loyalty tier based on previous play, and this tier is reflected in how much of their wagers contribute to the jackpot pool. The system may allocate 5% of a wager from an entry-level player, 10% from an intermediate-level player, and 15% from a VIP-tier player.

The loyalty tiers are managed by a central server, which tracks a player's betting history and adjusts their tier dynamically based on their playtime and wagering amounts. As the player progresses through the loyalty system, their contribution rate to the jackpot pool automatically adjusts. The ETGTs inform players about their current tier and the contribution percentage.

The jackpot server processes all bets and ensures that contributions are made according to the player's tier. Additionally, the system may offer enhanced rewards to higher-tier players by increasing their odds of winning or providing access to special jackpot events.

### Example Walk-Through Scenario:

Player A, a VIP-tier player, and Player B, an intermediate-tier player, are both seated at a live dealer-controlled blackjack table. Player A places a $100 bet, and Player B places a $50 bet. The ETGT system automatically calculates that Player A will contribute 15% of their wager to the jackpot pool, whereas Player B will contribute 10% of their wager.

As the game progresses, both players are notified through their ETGTs about their contribution levels. If a jackpot is triggered, Player A, being in the VIP tier, has a slightly higher chance of winning a larger portion of the jackpot. Player B, while contributing less, still benefits from being in a higher tier than a standard player.

The system keeps players engaged by showing how their loyalty status improves their odds and contributions to the jackpot, motivating them to remain active in the game.

### Player Interaction:

Players interact with this system by making their wagers as usual, but they are given real-time information about how their loyalty tier affects their jackpot contributions. VIP players, for instance, see that a larger portion of their wagers is contributing to the jackpot pool, and they may receive periodic updates on how close they are to advancing to the next loyalty tier.

This interaction adds an extra layer of excitement, as players may see tangible rewards for their loyalty and increased odds of hitting larger jackpots. They are incentivized to continue playing to maintain or increase their loyalty status, knowing that it directly impacts their potential jackpot winnings.

### Distinguishing Innovative Concepts:

This concept distinguishes itself by tying jackpot contributions directly to player loyalty, which is a novel approach compared to conventional fixed-rate jackpot contributions. Most progressive or mystery jackpots are based purely on the wager size or random triggers. By incorporating loyalty status, this system introduces a new dynamic, where players may increase their stake in the game by being regular participants.

The loyalty-driven contribution model also encourages long-term engagement, as players have a clear motivation to stay active and maintain or improve their loyalty tier for better jackpot opportunities.

### Distinguishing Inventive Steps:

1. Dynamic Contribution Adjustment: The system dynamically adjusts each player's jackpot contribution percentage based on their loyalty tier, ensuring that higher-tier players contribute more to the jackpot pool.
2. Loyalty-Based Incentives: Players are incentivized to increase their loyalty status for better odds and contributions to jackpots, creating a long-term engagement strategy.
3. Real-Time Feedback: Players receive real-time updates on their loyalty status and contributions, fostering a deeper connection between their play habits and jackpot opportunities.

These steps differentiate this system from traditional jackpot models by integrating player loyalty and creating a direct correlation between loyalty and jackpot contributions.

### 35 USC 101 Considerations:

This innovative concept provides a specific and concrete improvement over existing jackpot systems by incorporating player loyalty status into jackpot contributions. The system solves the problem of static contribution rates by introducing a dynamic model that adapts to player engagement and incentivizes long-term participation.

The system's real-time feedback, combined with dynamic jackpot contribution rates, provides a practical application of loyalty data to enhance the gaming experience. This technical integration of loyalty programs with jackpot systems goes beyond abstract concepts and offers a tangible improvement to the functionality of DETGs, making it patent-eligible.

### Data Input:

The primary data inputs come from player wagers and loyalty status. The system tracks each player's loyalty tier and adjusts their jackpot contribution rate accordingly. Additional data input includes player engagement metrics such as session time and wager amounts, which influence loyalty tier progression.

### Component Interactions and Procedural Steps:

1. Loyalty Tier Tracking: The casino network tracks each player's loyalty tier and sends this data to the ETGTs.
2. Contribution Calculation: Based on the player's loyalty tier, the system calculates how much of their wager contributes to the jackpot pool.
3. Player Notification: Players are notified in real-time about their contribution rate and loyalty status, which incentivizes them to continue playing.

### Data Processing:

The system processes player data, including wagers and loyalty status, to calculate jackpot contributions in real-time. It also adjusts each player's tier based on their play activity, ensuring that contributions reflect the most current loyalty status.

### Outputs and Responses:

The primary output is the real-time display of jackpot contribution rates on the ETGTs. Players receive immediate feedback on how their loyalty status affects their jackpot contributions. The system also updates the jackpot pool in real-time, reflecting the contributions from all players.

### Data Storage and Reporting:

The system stores data on player loyalty tiers, contributions to the jackpot, and jackpot trigger events. This data is used for loyalty program management and audit purposes, ensuring transparency in the jackpot process.

### Error Handling and Security Measures:

Error handling mechanisms ensure that loyalty tiers are accurately tracked and that jackpot contributions are calculated correctly. Security measures prevent tampering with loyalty data or jackpot contributions.

### End of Interaction:

Once a jackpot is triggered, the system processes the payout and resets for the next round of contributions. Players are notified of the final jackpot amount and their winnings, and the loyalty system continues tracking their progress for future games.

### Innovative Concept 55—Dealer-Initiated Jackpot Bonus Rounds

### Identification of Concept:

This innovative concept introduces a system where live dealers have the authority to trigger special jackpot bonus rounds during gameplay at DETG (Dealer-controlled Electronic Table Game) systems. The dealer may activate these high-stakes jackpot opportunities at their discretion, typically to enhance engagement, especially during peak hours, tournaments, or periods of intense player activity. These dealer-initiated bonus rounds increase excitement and create unique opportunities for players to win larger jackpots. The system is designed to offer dealers predefined windows during which they may initiate these bonus rounds, ensuring they are strategically timed to boost player engagement.

This concept is particularly suited to games like blackjack, baccarat, or roulette, where a dealer's interaction may significantly influence the game's flow and pace. By allowing dealers to initiate jackpot bonuses, casinos add a dynamic, human-driven element to jackpot systems, fostering a more interactive and immersive player experience.

### Sequence Diagram Components:

Electronic Table Game Terminals (ETGTs): These terminals serve as the interface through which players participate in the game. They display real-time updates and notifications of dealer-initiated jackpot bonus rounds and allow players to adjust their wagers accordingly.
Live Dealer: The notable actor in this system, with the authority to initiate special jackpot bonus rounds during gameplay. The dealer may trigger a jackpot round based on specific gameplay conditions or at designated times.
Casino Network: Communicates between the dealer, ETGTs, and the jackpot server, ensuring that jackpot bonus rounds are initiated and processed correctly.
Jackpot Server: Responsible for calculating the increased jackpot values during bonus rounds and distributing the winnings. It tracks all contributions from the bonus round and adjusts the payouts accordingly.
Players A, B, C: The players actively participating in the game who contribute to and benefit from the dealer-initiated jackpot round.
Bonus Activation Interface: A system that provides the dealer with the option to initiate a jackpot bonus round based on preset conditions or at their discretion.

### Implementation Details:

The system is implemented by integrating a dealer-triggered bonus activation feature within the casino network. The dealer, using a dedicated interface, may trigger a jackpot bonus round when certain conditions are met, such as reaching a specific number of bets, player participation level, or during promotional periods. This interface allows the dealer to initiate the bonus round, which adjusts the gameplay for the current session by increasing the jackpot pool and offering enhanced odds for players to win larger rewards.

The ETGTs are configured to display real-time information about the bonus round, alerting players when the jackpot stakes have been raised. This prompts players to increase their bets, knowing that they have a higher chance of winning a larger prize during this bonus round. The system automatically adjusts the jackpot pool, increasing the payout potential based on contributions made during the bonus round.

The dealer is also given the option to initiate bonus rounds during quieter periods to re-engage players and maintain high levels of activity. The system tracks each dealer's usage of the bonus round feature, ensuring that it is used strategically to enhance the gaming experience.

### Example Walk-Through Scenario:

At a live dealer-controlled baccarat table, Players A, B, and C are placing bets when the dealer decides to initiate a jackpot bonus round. The dealer taps a button on their control interface, activating the bonus round for the next five hands. A notification appears on all ETGTs, informing the players that the jackpot stakes have increased and that this round offers a special opportunity to win larger prizes.

As the bonus round begins, Players A, B, and C increase their bets, knowing that the chances of winning a significant jackpot are higher during this period. The jackpot server tracks all contributions made during the bonus round, increasing the overall jackpot pool. At the end of the bonus round, Player B hits a winning hand, triggering the jackpot. The system calculates the winnings based on the enhanced bonus round contributions, awarding Player B a significantly larger prize than they would have won during a regular round.

The bonus round ends after the specified hands, and the game returns to normal gameplay. However, the heightened excitement and the opportunity for a larger win have kept players engaged, and they continue playing longer than they originally planned.

### Player Interaction:

Players interact with this system primarily through their ETGTs, which provide real-time updates on when a jackpot bonus round has been initiated. When the dealer triggers the bonus round, players are immediately informed of the increased stakes, prompting them to adjust their bets to maximize their chances of winning during the high-stakes period.

This interaction encourages players to remain engaged, as the bonus rounds offer a unique opportunity to win larger prizes. Players may also adjust their betting strategies, placing larger bets during bonus rounds to capitalize on the enhanced jackpot potential.

### Distinguishing Innovative Concepts:

This concept distinguishes itself by giving dealers the ability to dynamically influence the flow of the game by initiating jackpot bonus rounds. Unlike traditional jackpot systems that are triggered randomly or based on player actions, this system allows dealers to strategically introduce high-stakes opportunities at optimal moments, adding a human-driven element to the jackpot system.

The dealer-initiated bonus round creates a more interactive and engaging experience for players, as they are directly influenced by the dealer's decisions. This level of interactivity and control is not present in conventional jackpot systems, making this concept a novel approach to enhancing player engagement.

### Distinguishing Inventive Steps:

1. Dealer-Controlled Bonus Round Activation: The system allows the dealer to trigger a special jackpot bonus round at their discretion, creating a dynamic and responsive gaming environment.
2. Enhanced Jackpot Stakes During Bonus Rounds: During the dealer-initiated bonus round, the system increases the jackpot stakes, offering players a higher potential payout.
3. Real-Time Player Notifications: The ETGTs provide real-time updates to players, notifying them when the bonus round has been activated and encouraging them to adjust their bets accordingly.

These steps distinguish this system from conventional jackpot models by incorporating dealer actions into the jackpot-triggering process, creating a more interactive and exciting player experience.

### 35 USC 101 Considerations:

The dealer-initiated jackpot bonus round system provides a concrete improvement over existing jackpot mechanisms by integrating real-time dealer interaction into the gameplay. This system solves the problem of passive dealer involvement by allowing them to actively enhance the player experience, making the game more engaging and dynamic.

By allowing dealers to trigger jackpot bonus rounds, the system introduces a novel, non-abstract improvement to DETG systems. This practical application integrates human-driven decisions into the gameplay, enhancing the overall functionality of live dealer-controlled games and providing a patent-eligible advancement in casino gaming technology.

### Data Input:

The system collects input from the dealer's bonus round activation interface and player wagers during the bonus round. The dealer's decision to initiate the round, combined with player activity data, influences the jackpot pool calculations and determines the payout potential.

### Component Interactions and Procedural Steps:

1. Dealer Bonus Round Activation: The dealer triggers the bonus round using their control interface, sending a signal to the casino network.
2. Jackpot Pool Adjustment: The jackpot server adjusts the pool based on the contributions made during the bonus round, increasing the potential payout for players.
3. Real-Time Player Updates: The ETGTs display real-time updates to players, informing them of the bonus round activation and prompting them to adjust their bets.

### Data Processing:

The system processes real-time data from the dealer's bonus round activation and player wagers to calculate the enhanced jackpot pool. The jackpot server continuously updates the pool during the bonus round, ensuring that contributions are accurately tracked and reflected in the final payout.

### Outputs and Responses:

The primary output is the notification sent to players through their ETGTs, informing them of the dealer-initiated bonus round. Players are encouraged to adjust their bets, and the system dynamically updates the jackpot pool based on the increased stakes during the bonus round.

### Data Storage and Reporting:

The system stores data on all dealer-initiated bonus rounds, including when they were triggered, the total contributions made, and the final jackpot payout. This data is used for audit purposes and to track dealer performance in initiating bonus rounds.

### Error Handling and Security Measures:

Error handling mechanisms ensure that the bonus round is only triggered at appropriate times and that the jackpot pool is accurately adjusted based on player contributions. Security measures prevent unauthorized triggering of bonus rounds and ensure that the system operates fairly.

### End of Interaction:

Once the bonus round is completed, the system returns to normal gameplay, resetting the jackpot pool and notifying players that the bonus round has ended. The dealer may initiate another bonus round at their discretion during future gameplay sessions.

### Innovative Concept 56—Jackpot Triggers Tied to Specific Sequences of Wins or Losses Across Multiple Networked DETGs

### Identification of Concept:

This innovative concept introduces a jackpot trigger mechanism based on specific sequences of wins or losses occurring across multiple networked DETG (Dealer-controlled Electronic Table Game) systems. The jackpot may be designed to trigger after predefined sequences of wins (e.g., three consecutive wins by the dealer) or losses (e.g., five consecutive losses by players), creating a heightened sense of anticipation for players. The feature ties individual game outcomes across different terminals, fostering a networked gaming experience where all participants at multiple DETGs contribute to and await the outcome of a shared jackpot pool.

The system tracks these win/loss sequences in real-time across multiple DETGs, encouraging players to remain engaged by adding an additional layer of excitement to standard game mechanics. For example, the jackpot may trigger if players in different games across several DETGs experience back-to-back wins or losses, transforming individual successes or failures into a collective anticipation of a large reward.

### Sequence Diagram Components:

Electronic Table Game Terminals (ETGTs): Players interact with these terminals, which display real-time updates on the progress toward triggering the jackpot based on sequences of wins or losses across the networked games.
Live Dealer: Oversees gameplay, with the system tracking sequences of wins and losses by the dealer and players across all participating DETGs.
Casino Network: Monitors the gameplay at all connected DETGs, tracking win/loss sequences across the network to determine when the jackpot should be triggered.
Jackpot Server: Manages the jackpot pool, ensuring contributions are made based on player wagers and determining when a jackpot is triggered based on predefined win/loss sequences.
Players A, B, C: The individual players whose game outcomes contribute to the win/loss sequences that may trigger the jackpot.
Win/Loss Sequence Tracker: A backend system component responsible for identifying when the predefined win/loss sequences occur, across multiple DETGs, to trigger the jackpot.

### Implementation Details:

This concept may be implemented by integrating a sequence tracking mechanism within the casino's DETG network. Each ETGT tracks player and dealer wins and losses in real-time. The casino network aggregates these results across all connected DETGs and monitors for predefined sequences (e.g., three consecutive player wins at one terminal and two consecutive losses at another terminal). The win/loss sequence tracker works with the jackpot server to identify when the required sequence is achieved.

The casino may customize which sequences trigger the jackpot, ensuring flexibility based on game type and player preferences. For example, sequences of wins in blackjack or poker games may differ from those in baccarat, yet all contribute to the shared jackpot pool. The system dynamically updates each player's terminal, providing real-time notifications as the tracked sequences progress, increasing player anticipation.

This multi-terminal win/loss tracking fosters greater interactivity, transforming individual game outcomes into a shared, network-wide experience that culminates in a highly anticipated jackpot trigger.

### Example Walk-Through Scenario:

At a live dealer-controlled blackjack table, Player A wins two consecutive hands, while at a baccarat table, Player B experiences three consecutive losses. The system recognizes this combination of wins and losses as meeting the criteria for a jackpot trigger. As the rounds progress, Players A and B are notified via their ETGTs that the sequence is close to triggering a jackpot.

The casino network monitors the ongoing game results at both tables, tracking win/loss sequences in real-time. The tension builds as Player C, playing at a poker table, secures two more consecutive wins. This completes the predefined sequence of events needed to trigger the jackpot. The jackpot server is notified, and the mystery jackpot is activated across the networked DETGs, with all participating players sharing in the payout based on their contributions.

### Player Interaction:

Players engage with this system through their ETGTs, which display real-time updates on the sequence of wins or losses contributing to the jackpot trigger. As they play, they may see how their individual results are contributing to the overall progress toward the jackpot. This creates a sense of involvement and shared anticipation among all players, as they collectively work toward triggering the jackpot.

This system adds an additional layer of excitement to the traditional gaming experience, as players are not only focused on their own success but also on the success (or failure) of players across other DETGs.

### Distinguishing Innovative Concepts:

One aspect of novelty of this concept lies in the use of win/loss sequences across multiple DETGs to trigger jackpots. Traditional jackpot systems are often tied to individual players' performance or random triggers. In contrast, this system dynamically links multiple gaming terminals, allowing the results from different players and games to contribute to a shared jackpot event.

This multi-game, networked approach creates a more social and collaborative gaming experience, where the actions of players at different DETGs affect each other's potential to win a large jackpot, thereby increasing player engagement and session duration.

### Distinguishing Inventive Steps:

1. Cross-DETGs Win/Loss Sequence Tracking: The system tracks win/loss sequences across multiple DETGs in real-time, dynamically updating the jackpot trigger criteria based on player outcomes.
2. Networked Jackpot Contributions: Contributions to the jackpot pool are aggregated from all participating DETGs, creating a shared experience across multiple games and terminals.
3. Real-Time Jackpot Trigger Notifications: Players are kept informed of their progress toward triggering the jackpot through real-time updates displayed on their ETGTs, fostering engagement.

These steps distinguish this system from traditional jackpot models by leveraging the results of multiple players and games to create a shared jackpot experience that encourages longer playtimes and increased interaction.

### 35 USC 101 Considerations:

The innovative concept provides a concrete improvement over existing jackpot systems by using cross-DETGs win/loss sequences to dynamically trigger jackpots. This approach solves the problem of isolated jackpot experiences by creating a shared, networked environment that ties multiple players' outcomes together.

The system's real-time monitoring and notification features provide a practical, non-abstract improvement to DETG functionality, as players are now engaged in a larger, network-wide experience. This technical integration represents a novel, patent-eligible advancement in casino gaming technology, as it introduces a new method of triggering jackpots based on game outcomes across a network.

### Data Input:

Data inputs for this system include each player's game results, including wins and losses, which are tracked across all networked DETGs. The system also collects information on player wagers, which contribute to the jackpot pool and are factored into the payout distribution when the jackpot is triggered.

### Component Interactions and Procedural Steps:

1. Win/Loss Tracking: The system tracks wins and losses in real-time across all connected DETGs, monitoring for predefined sequences.
2. Sequence Recognition: When a specific sequence of wins or losses occurs, the system recognizes this and triggers the jackpot.
3. Jackpot Distribution: The jackpot server calculates the payout based on contributions and distributes the winnings to all eligible players.

### Data Processing:

The system processes data on player performance, identifying specific sequences of wins or losses across networked DETGs. This data is used to trigger the jackpot when the required conditions are met. The system also processes player wagers to calculate contributions to the jackpot pool.

### Outputs and Responses:

The primary output is the real-time update to players, notifying them of the jackpot trigger conditions and the progress of the win/loss sequence. Once the jackpot is triggered, the system notifies all participating players and distributes the winnings accordingly.

### Data Storage and Reporting:

The system stores data on all win/loss sequences, player contributions, and jackpot triggers. This data is used for auditing purposes and to ensure transparency in the jackpot system.

### Error Handling and Security Measures:

Error handling ensures that the win/loss sequences are tracked accurately and that the jackpot is triggered correctly. Security measures protect the integrity of the jackpot pool and prevent tampering with player results or contributions.

### End of Interaction:

After the jackpot is triggered and the winnings are distributed, the system resets the win/loss sequence tracker and begins monitoring for the next qualifying sequence. Players are notified of the final results, and the game continues with new potential jackpot triggers.

### Innovative Concept 57—Virtual “Jackpot Token” System

### Identification of Concept:

This innovative concept introduces a virtual “Jackpot Token” system that players may earn and collect during gameplay, enhancing their odds of triggering mystery jackpots. The tokens serve as a virtual currency or collectible item that players may accumulate over time by placing wagers, winning specific game events, or achieving certain milestones within the DETG system. These tokens increase a player's probability of triggering a jackpot, giving players an incentive to remain engaged for longer periods and accumulate more tokens. The virtual token system also allows players to manage their tokens across multiple game sessions and DETGs, providing an additional layer of strategy as they decide when to use their tokens to maximize jackpot-winning potential.

### Sequence Diagram Components:

Electronic Table Game Terminals (ETGTs): Players interact with these terminals, where they earn, view, and redeem their virtual jackpot tokens. The ETGTs track token accumulation and notify players of how these tokens affect their chances of triggering a jackpot.
Casino Network: The network manages player data, including the collection and usage of jackpot tokens across different DETGs. It tracks token balances, adjusts jackpot trigger probabilities based on token usage, and synchronizes token information across all connected terminals.
Jackpot Server: The jackpot server calculates jackpot trigger probabilities based on the number of tokens each player has accumulated and their decision to use them in a particular game session. It ensures that the system properly accounts for the enhanced chances of winning associated with token use.
Players A, B, C: Players who earn virtual jackpot tokens by playing different DETGs. Each player may choose when and how to use their tokens to increase their jackpot chances.
Token Management System: A backend system that handles the tracking, accumulation, and redemption of tokens. It ensures that players' token balances are updated in real-time and that the tokens are applied correctly during gameplay.

### Implementation Details:

The virtual jackpot token system is integrated into the DETG network, with each ETGT automatically tracking the tokens earned by players as they participate in various games. Tokens may be earned through multiple means, such as placing high-value wagers, hitting certain winning hands, or staying engaged for a defined period. The tokens are stored in a player's virtual wallet, and players may choose to redeem them during specific game sessions to boost their odds of triggering a mystery jackpot.

The jackpot server dynamically adjusts the jackpot trigger probabilities based on the number of tokens a player has chosen to use in a session. For example, a player with a large token balance may use a portion of their tokens to increase their odds of triggering the jackpot during a particular game round. The more tokens used, the higher the probability of winning.

The token management system ensures that players may view their token balances and track their progress through the ETGT interface. It also handles the backend synchronization of tokens across multiple DETGs, allowing players to earn and use their tokens at any table in the casino network.

### Example Walk-Through Scenario:

Player A, having accumulated 50 virtual jackpot tokens from previous baccarat sessions, sits down at a live dealer-controlled roulette game. Player A decides to use 10 of their tokens to increase their odds of triggering the mystery jackpot during the upcoming rounds. The ETGT displays Player A's current token balance and confirms the increased probability of winning a jackpot due to token usage.

As the roulette rounds progress, Player B, who has also accumulated tokens but chooses not to use them yet, continues playing normally. The casino network tracks Player A's enhanced jackpot probability in real-time and adjusts the mystery jackpot system accordingly. Midway through the session, Player A triggers the mystery jackpot, benefiting from the token-enhanced probability. The jackpot server calculates the winnings, and Player A receives a portion of the jackpot based on their wagers and token usage.

Meanwhile, Player B, who chose to save their tokens for a future session, continues earning more tokens with each bet, knowing that they may later use them to boost their jackpot chances when they feel the time is right.

### Player Interaction:

Players interact with this system through their ETGTs, where they may view their current token balance, monitor how close they are to earning additional tokens, and decide when to redeem tokens to enhance their jackpot odds. Players are incentivized to remain engaged and participate in multiple rounds or game sessions, as earning and collecting tokens provides a tangible benefit toward potentially triggering a jackpot.

This system adds a strategic layer to gameplay, as players must decide when to use their tokens to maximize their chances of winning. Additionally, the ability to accumulate tokens over time gives players a sense of progression and control, making the gaming experience more personalized and rewarding.

### Distinguishing Innovative Concepts:

This concept is distinguished by its use of virtual tokens as a collectible resource that directly impacts a player's probability of triggering a jackpot. Unlike conventional jackpot systems, where the trigger is random or solely based on wager size, this system allows players to strategically accumulate and use tokens to enhance their chances of winning.

The use of tokens adds a layer of engagement and strategy that encourages longer playtimes and greater player loyalty, as players are motivated to keep playing to earn more tokens. The virtual token system is also customizable, allowing casinos to tailor how tokens are earned and used, depending on player behavior and preferences.

### Distinguishing Inventive Steps:

1. Token-Based Jackpot Probability Enhancement: Players accumulate tokens that directly increase their odds of triggering a jackpot when used, adding a unique strategic element to gameplay.
2. Cross-Session Token Accumulation: Tokens are accumulated and stored across multiple game sessions, allowing players to carry over their progress and strategically plan their jackpot pursuits.
3. Dynamic Jackpot Triggering: The jackpot server dynamically adjusts the trigger probability based on the number of tokens used by players, ensuring that token use has a meaningful impact on gameplay outcomes.

These steps distinguish this system from conventional mystery jackpots by introducing a token-based mechanic that gives players control over their chances of triggering a jackpot.

### 35 USC 101 Considerations:

The virtual jackpot token system offers a concrete improvement over traditional jackpot mechanisms by introducing a player-driven method of influencing jackpot triggers. This system solves the problem of passive jackpot experiences by allowing players to actively participate in increasing their chances of winning, based on their engagement and gameplay behavior.

This system goes beyond an abstract idea by providing a real-time, interactive application where players accumulate, manage, and redeem tokens to influence game outcomes. The use of virtual tokens as a tangible game mechanic represents a novel, patent-eligible advancement in DETG gaming technology, providing a specific improvement in player engagement and game dynamics.

### Data Input:

The system collects data on player wagers, game outcomes, and token earnings. Each ETGT tracks how many tokens a player has accumulated and when they choose to redeem those tokens to enhance their jackpot odds. The system also processes inputs related to player decisions on token usage.

### Component Interactions and Procedural Steps:

1. Token Accumulation: Players earn tokens based on their wagers and game outcomes. The system tracks these tokens and updates the player's balance in real-time.
2. Token Redemption: Players decide when to use their tokens to increase their jackpot chances. The system adjusts the jackpot trigger probabilities accordingly.
3. Jackpot Trigger: The jackpot server monitors token-enhanced probabilities and triggers the jackpot based on the adjusted odds, distributing winnings when appropriate.

### Data Processing:

The system processes player data to track token accumulation and manage the increased jackpot trigger probabilities when tokens are redeemed. The token management system ensures that all token balances and probabilities are synchronized across the casino network.

### Outputs and Responses:

The primary outputs include real-time updates on token balances and notifications when tokens are redeemed to enhance jackpot odds. Players receive feedback on how their token usage has impacted their chances of winning a jackpot, and the system notifies all players when a jackpot is triggered.

### Data Storage and Reporting:

The system stores player token balances, jackpot contributions, and usage data for audit and reporting purposes. This data is used to track player activity, token earnings, and jackpot triggers across multiple DETGs.

### Error Handling and Security Measures:

Error handling ensures that tokens are accurately tracked and redeemed, preventing misuse or loss of tokens. Security measures protect the integrity of the token system, ensuring that token balances cannot be tampered with and that jackpot triggers are calculated fairly.

### End of Interaction:

Once the jackpot is triggered and winnings are distributed, the system resets the token-enhanced jackpot probabilities, and players may continue accumulating and using tokens in future sessions. Players are notified of the final results, and the system prepares for the next potential jackpot event.

Innovative Concept 58—Shared Mystery Jackpot Across Multiple Game Types with Weighted Contribution Based on Game Complexity

### Identification of Concept:

This concept introduces a shared mystery jackpot system that spans multiple game types at Dealer-controlled Electronic Table Games (DETGs). Contributions to the jackpot are weighted according to the complexity or skill level of each game. More complex games (such as blackjack or poker) may contribute a larger portion of the player's wager to the mystery jackpot pool, while simpler games (like baccarat or roulette) contribute a smaller portion. This approach incentivizes players to participate in a variety of games, as each game has a different impact on the overall jackpot.

The system dynamically adjusts the contribution percentage based on the game type and real-time player activity, creating a shared jackpot pool that grows based on a combination of game complexity and wager volume. Players from various games are linked to the same jackpot pool, which adds an additional layer of excitement, as different types of players are all contributing to and competing for the same mystery jackpot.

### Sequence Diagram Components:

Electronic Table Game Terminals (ETGTs): Display real-time updates on the current jackpot value and communicate the contribution percentage based on the game being played. ETGTs handle the weighted contributions and provide feedback to players.
Casino Network: Tracks the wager contributions from each DETG and adjusts the percentage based on the game type. It synchronizes this data with the jackpot server to ensure that the shared pool reflects contributions from all game types.
Jackpot Server: Manages the shared jackpot pool, applying weighted contributions based on game complexity and distributing the jackpot when triggered.
Players A, B, C (Playing Different Games): Players participating in different games (e.g., blackjack, baccarat, roulette) contribute to the shared jackpot pool. Their contributions are weighted according to the complexity of the game.
Game Complexity Weighting System: A backend system component that calculates the contribution percentage based on game complexity and adjusts the amount added to the jackpot pool accordingly.

### Implementation Details:

The shared jackpot system is integrated across multiple DETGs, each offering different game types. For example, blackjack may be considered a higher-complexity game due to the strategic decision-making involved, while roulette or baccarat may be classified as lower-complexity games based on their reliance on chance. The system dynamically adjusts the contribution percentage from each wager, ensuring that more complex games contribute a higher percentage to the jackpot pool.

When a player places a wager, the ETGT communicates the game type to the casino network, which calculates the appropriate contribution based on a predefined weighting system. The jackpot server consolidates these contributions in real-time, updating the shared jackpot pool displayed across all DETGTs.

For example, a $100 wager on blackjack may contribute 5% ($5) to the jackpot, while a similar wager on roulette may only contribute 2% ($2). This weighted system encourages players to engage with more complex games, as their wagers have a greater impact on the shared jackpot pool.

### Example Walk-Through Scenario:

Player A is playing blackjack at a live dealer-controlled table, while Player B is engaged in baccarat, and Player C is playing roulette. All three players are contributing to the same shared mystery jackpot, but the contribution percentages differ based on the complexity of the games.

As Player A places a $50 bet on blackjack, the system applies a 5% contribution, adding $2.50 to the jackpot pool. Meanwhile, Player B's $50 bet on baccarat contributes 3% ($1.50) to the jackpot, and Player C's $50 bet on roulette adds 2% ($1) to the pool.

The shared jackpot pool grows dynamically as more players place wagers across different games. The ETGTs display real-time updates on the jackpot total, creating a sense of shared competition among the players, even though they are participating in different games.

Eventually, the mystery jackpot is triggered by a random event at one of the tables, and the system calculates the payout based on the current jackpot pool.

### Player Interaction:

Players interact with the system by placing wagers on their preferred games. The ETGTs automatically handle the weighted contribution calculations, allowing players to focus on their gameplay. Real-time updates on the growing jackpot are displayed on the ETGTs, encouraging continued participation.

This interaction creates an exciting environment where players from different games feel connected through the shared jackpot pool. The weighted contribution system adds an extra layer of strategy for players who want to maximize their impact on the jackpot.

### Distinguishing Innovative Concepts:

This innovative concept introduces a dynamic, weighted contribution system that adjusts based on game complexity, offering a novel way to link multiple game types to the same shared jackpot. Unlike traditional jackpot systems that apply uniform contributions across all games, this approach recognizes the varying levels of skill and strategy required for different games, rewarding players who engage with more complex games.

The shared mystery jackpot creates a cross-game competition that keeps players engaged, as they know that their participation in different games contributes to the same growing jackpot pool.

### Distinguishing Inventive Steps:

1. Weighted Jackpot Contributions: The system applies different contribution percentages based on the complexity of the game being played, dynamically adjusting the jackpot pool growth based on real-time activity.
2. Cross-Game Shared Jackpot: Players from multiple game types contribute to and compete for the same mystery jackpot, creating a sense of shared excitement across the casino.
3. Real-Time Contribution Tracking: The casino network tracks and adjusts contributions in real-time, ensuring that the jackpot pool reflects the wagers from all participating DETGs.

These steps differentiate this system from conventional jackpot models by introducing a weighted contribution mechanism and a shared jackpot pool across multiple game types, enhancing player engagement and excitement.

### 35 USC 101 Considerations:

This innovative concept provides a concrete improvement over traditional jackpot systems by introducing a dynamic, weighted contribution system based on game complexity. The system solves the problem of uniform jackpot contributions by tailoring the percentage based on the skill and strategy involved in each game, creating a more engaging and equitable jackpot experience.

This technical solution integrates real-time contribution tracking and dynamic jackpot adjustments, going beyond abstract ideas to offer a practical improvement in casino gaming functionality. The use of weighted contributions for a shared jackpot pool represents a novel and patent-eligible advancement in gaming technology.

### Data Input:

The system collects data on player wagers and game types across multiple DETGs. This data is used to calculate the weighted contributions to the shared jackpot pool, with different percentages applied based on the complexity of the game being played.

### Component Interactions and Procedural Steps:

1. Game Type Identification: The system identifies the type of game being played at each DETG and applies the appropriate contribution percentage based on the predefined weighting system.
2. Wager Contribution Calculation: The system calculates the contribution from each wager and adds it to the shared jackpot pool in real-time.
3. Real-Time Jackpot Update: The jackpot server updates the total jackpot value across all participating DETGs, providing players with live updates on the growing pool.

### Data Processing:

The system processes data on player wagers and game complexity to calculate the weighted contributions to the shared jackpot pool. The jackpot server continuously updates the pool based on real-time contributions from multiple DETGs.

### Outputs and Responses:

The primary output is the real-time update of the jackpot pool displayed on the ETGTs. The system also processes and distributes the jackpot payout when triggered, ensuring that the winnings are calculated based on the current pool.

### Data Storage and Reporting:

The system stores data on player wagers, game types, and jackpot contributions. This data is used for audit and reporting purposes, ensuring transparency in the jackpot system and providing insights into player behavior.

### Error Handling and Security Measures:

Error handling ensures that the correct contribution percentages are applied based on the game type and that the jackpot pool is updated accurately. Security measures protect the integrity of the system, preventing unauthorized access or manipulation of the jackpot contributions.

### End of Interaction:

Once the jackpot is triggered, the system resets the pool and begins accumulating contributions for the next jackpot. Players are notified of the outcome, and the process continues with new wagers and contributions across multiple game types.

### Innovative Concept 59—Jackpot Eligibility Tied to Player-Selected “Hot” and “Cold” DETGs

### Identification of Concept:

This innovative concept allows players to enhance their jackpot-winning potential by selecting “hot” or “cold” DETGs (Dealer-controlled Electronic Table Games) based on real-time performance tracking. “Hot” tables are identified as those that have recently experienced frequent wins or high activity, while “cold” tables are those with fewer wins or lower activity. Players may choose to play at either type of table, with each selection offering different jackpot benefits. For example, a “hot” table may offer higher jackpot triggers due to the table's winning streak, whereas a “cold” table may have a built-up jackpot pool, offering a larger payout when the next win occurs.

This system encourages players to strategically choose their table based on their risk tolerance and preferences, adding a layer of decision-making to the jackpot process. By allowing players to select tables based on “hot” or “cold” status, the system introduces a new dynamic in live dealer-controlled multiplayer DETGs, where real-time data influences jackpot eligibility and outcomes.

### Sequence Diagram Components:

Electronic Table Game Terminals (ETGTs): Players interact with the ETGTs to view the current “hot” or “cold” status of available DETGs, along with the associated jackpot conditions. The terminals track the player's selected table and update the jackpot eligibility accordingly.
Live Dealer: Oversees the game and provides feedback on the table's current performance (i.e., hot or cold status) as part of the gameplay experience.
Casino Network: Tracks the real-time performance of all DETGs in the casino network, classifying each table as “hot” or “cold” based on predefined win/loss criteria. It communicates this data to the jackpot server.
Jackpot Server: Manages the jackpot pool and adjusts trigger conditions based on the player's choice of a “hot” or “cold” table. It ensures that the jackpot payout odds reflect the status of the selected DETG.
Player A (Hot Table), Player B (Cold Table): Players who select different types of tables based on their preferences, each with distinct jackpot probabilities or payout amounts.
Hot/Cold Table Classifier: A backend component that analyzes game outcomes and activity levels at each DETG, categorizing tables as “hot” or “cold” in real-time.

### Implementation Details:

The casino network monitors all DETGs and continuously analyzes game data to classify tables as “hot” or “cold” based on recent win/loss streaks, the amount of player activity, and the overall jackpot contributions. This classification is updated in real-time and displayed on each ETGT, giving players the option to select a table based on its current status.

For example, a “hot” table may be defined as one where a series of consecutive wins has occurred within a short period, leading to increased jackpot odds for subsequent rounds. Conversely, a “cold” table may not have triggered a jackpot in a while, causing the jackpot pool to grow, making it more appealing to players looking for a larger payout.

Players may review this data and make an informed decision about where to play. Once a player selects a table, the jackpot server adjusts the trigger conditions based on the chosen table's status. “Hot” tables may offer more frequent jackpot triggers but with smaller payouts, while “cold” tables may have higher thresholds but larger potential jackpots.

### Example Walk-Through Scenario:

Player A and Player B are browsing the available DETGs. Player A chooses a “hot” table, which has seen several recent wins. The ETGT informs Player A that the odds of triggering a jackpot at this table are higher, but the potential payout is moderate. Player A begins placing bets, knowing that the frequent wins increase the likelihood of a jackpot trigger.

Player B, on the other hand, selects a “cold” table, which has not triggered a jackpot for several rounds. The ETGT informs Player B that while the odds of triggering the jackpot are lower, the jackpot pool has accumulated to a significant amount, promising a larger payout if triggered.

Both players continue placing their bets based on their chosen table's status. As Player A plays at the “hot” table, the jackpot triggers, awarding a smaller, more frequent prize. Meanwhile, Player B's patience pays off when a large jackpot is triggered after an extended losing streak at the “cold” table.

### Player Interaction:

Players interact with the system by choosing between “hot” and “cold” DETGs, with each option providing different jackpot opportunities. The ETGTs display real-time updates on each table's classification, giving players the information they need to make strategic decisions. This interaction introduces a layer of strategy to the game, as players must weigh the benefits of frequent, smaller jackpots at “hot” tables versus larger, less frequent jackpots at “cold” tables.

This system keeps players engaged by offering them the ability to influence their jackpot experience through table selection, rather than relying solely on random triggers.

### Distinguishing Innovative Concepts:

The notable innovation of this concept is the introduction of real-time table classification (“hot” or “cold”) into the jackpot trigger process. Unlike conventional systems that treat all DETGs equally in terms of jackpot odds, this system allows players to choose their level of risk and reward based on real-time performance data. This dynamic classification adds a strategic element to the game, as players may actively choose which table to play at based on their preferences for frequent wins or larger jackpots.

The ability to select “hot” or “cold” tables creates a more personalized gaming experience, where players may tailor their gameplay to suit their individual risk tolerance and jackpot goals.

### Distinguishing Inventive Steps:

1. Real-Time Table Classification: The system continuously monitors DETGs to classify them as “hot” or “cold” based on recent win/loss data and player activity, providing players with updated information on each table's status.
2. Player-Selected Jackpot Strategy: Players may choose between “hot” and “cold” tables, each offering different jackpot conditions, allowing for a more strategic and personalized gaming experience.
3. Dynamic Jackpot Odds Adjustment: The jackpot server dynamically adjusts the trigger conditions based on the player's table selection, ensuring that “hot” tables have more frequent triggers but smaller payouts, while “cold” tables offer larger, less frequent jackpots.

These steps distinguish this system from traditional jackpot models by incorporating real-time performance data and offering players the ability to influence their jackpot odds based on table selection.

### 35 USC 101 Considerations:

This innovative concept provides a concrete improvement over traditional jackpot systems by integrating real-time performance data into the jackpot trigger mechanism. The system solves the problem of static jackpot odds by allowing players to choose between “hot” and “cold” tables, each with distinct jackpot conditions based on real-time data.

This system goes beyond an abstract idea by providing a practical, interactive solution that enhances the player's ability to control their jackpot experience. The use of real-time table classification and dynamic jackpot odds adjustment represents a novel, patent-eligible advancement in casino gaming technology.

### Data Input:

The system collects real-time game outcomes from each DETG, including win/loss streaks and player activity levels. Players input their table selection through the ETGTs, choosing between “hot” or “cold” tables based on the system's real-time classifications.

### Component Interactions and Procedural Steps:

1. Table Performance Monitoring: The casino network continuously tracks the win/loss data and player activity at each DETG, classifying tables as “hot” or “cold.”
2. Player Table Selection: Players choose their table based on the real-time classification, with the system adjusting jackpot trigger conditions accordingly.
3. Dynamic Jackpot Calculation: The jackpot server adjusts the odds and potential payout based on the player's choice of a “hot” or “cold” table.

### Data Processing:

The system processes real-time performance data from each DETG, updating the classification of tables as “hot” or “cold.” It also processes player selections and adjusts the jackpot trigger conditions based on the chosen table's status.

### Outputs and Responses:

The primary output is the real-time classification of DETGs as “hot” or “cold,” displayed on the ETGTs. Players receive feedback on the jackpot odds and potential payouts based on their table selection, and the system dynamically adjusts the jackpot pool and trigger conditions.

### Data Storage and Reporting:

The system stores data on each table's classification, player selections, and jackpot outcomes for audit and reporting purposes. This data is used to track player behavior and table performance over time.

### Error Handling and Security Measures:

Error handling ensures that table classifications are accurate and that the correct jackpot odds are applied based on player selections. Security measures protect the integrity of the classification system and prevent tampering with table data.

### End of Interaction:

Once a jackpot is triggered, the system resets the “hot” and “cold” classifications for all DETGs, and players are notified of the final results. The system continues tracking real-time data to update table statuses for future sessions.

### Innovative Concept 60—Jackpot Boost Linked to Consecutive Player Wins in Multi-Game Sessions

### Identification of Concept:

This innovative concept ties jackpot boosts to consecutive player wins across multiple gaming sessions at Dealer-controlled Electronic Table Games (DETGs). Players who achieve a series of consecutive wins, either in a single session or over several game sessions, are rewarded with an increased chance of triggering a mystery jackpot or directly adding to the jackpot pool. The system dynamically tracks each player's win streaks across various DETGs, allowing the jackpot boost to accumulate as long as the player continues winning.

This feature adds an additional layer of excitement and motivation for players to stay engaged, as winning streaks are directly tied to jackpot potential. The consecutive win-based jackpot boost may be applied across various game types such as blackjack, baccarat, or roulette, making the concept adaptable for different player preferences and increasing the system's appeal.

### Sequence Diagram Components:

Electronic Table Game Terminals (ETGTs): Displays real-time information about players' consecutive wins and notifies them of their enhanced jackpot potential. It allows players to track their win streaks and how they contribute to the jackpot.
Casino Network: Monitors and logs player activity, including consecutive wins across multiple DETGs, and communicates with the jackpot server to adjust players' jackpot potential based on their streaks.
Jackpot Server: Manages the jackpot pool, adjusting it based on player contributions and win streaks. The server dynamically increases jackpot odds or adds to the pool as players extend their winning streaks.
Players A, B, C: Players who engage with the system through their ETGTs, achieving consecutive wins and increasing their jackpot potential.
Win Streak Tracker: A backend system component that tracks consecutive wins and updates the jackpot odds accordingly, applying boosts when players reach specific thresholds.

### Implementation Details:

The system is configured to track players' consecutive wins across all DETGs connected to the casino network. Each ETGT monitors the outcome of every game and communicates this data to the win streak tracker, which calculates the number of consecutive wins. As players achieve a predetermined number of consecutive wins (e.g., three or more), the system either increases their probability of triggering a jackpot or directly boosts the jackpot pool based on the player's bet size and streak length.

The jackpot server dynamically adjusts the odds based on real-time data, ensuring that players who maintain winning streaks receive tangible benefits, such as higher chances of winning larger jackpots. The ETGTs provide feedback to players, informing them of their current win streak and how it is affecting their jackpot potential.

In some implementations, players may also receive notifications encouraging them to continue playing to extend their streaks and increase their chances of hitting the jackpot. This feature is particularly beneficial for live dealer games like blackjack, where player skill and strategy may influence win streaks, making the game more engaging for experienced players.

### Example Walk-Through Scenario:

Player A, a regular participant at a live dealer-controlled baccarat table, begins a game session and wins three consecutive hands. The ETGT immediately notifies Player A that their consecutive wins have increased their chances of triggering a jackpot. Player A's consecutive wins are tracked in real-time by the win streak tracker, which communicates with the jackpot server to adjust the jackpot odds.

Meanwhile, Player B, playing at a blackjack table, achieves five consecutive wins. Player B receives a notification that not only has their jackpot potential increased, but a portion of their winnings has also been added to the jackpot pool. Both players are incentivized to continue their winning streaks, knowing that every additional win further boosts their chances of hitting a significant jackpot.

As Player A continues playing and wins two more rounds, the system further increases the jackpot odds, making it more that the next jackpot trigger will result in a payout. Eventually, Player A hits the jackpot after a series of eight consecutive wins, receiving a larger prize due to the win streak boost.

### Player Interaction:

Players interact with the system by participating in standard gameplay. As they win consecutive rounds, the ETGT tracks their progress and provides real-time updates on their jackpot potential. Players are notified of their current streak and how it influences their odds of hitting the jackpot, encouraging them to continue playing to maximize their rewards.

This system adds a competitive element to the gameplay, as players are motivated to achieve and maintain winning streaks to enhance their chances of triggering a jackpot. The interaction remains seamless, as the tracking and jackpot adjustments occur in the background, allowing players to focus on the game while benefiting from their success.

### Distinguishing Innovative Concepts:

This concept distinguishes itself by linking jackpot potential directly to player performance across multiple game sessions, specifically through consecutive wins. Unlike conventional jackpot systems that rely on random triggers or wager size, this system rewards player skill and persistence, creating a more engaging and rewarding experience.

The dynamic adjustment of jackpot odds based on win streaks introduces a novel feature that adds excitement to live dealer games. By tracking performance across sessions, the system encourages long-term engagement and fosters a sense of progression, as players may actively work toward increasing their jackpot potential.

### Distinguishing Inventive Steps:

1. Win Streak-Based Jackpot Boost: The system tracks consecutive wins and dynamically adjusts the jackpot potential based on the player's performance, creating a direct link between gameplay and jackpot rewards.
2. Cross-Session Streak Tracking: Player win streaks are tracked across multiple game sessions, allowing for a cumulative boost to jackpot potential that extends beyond a single game.
3. Real-Time Jackpot Odds Adjustment: The jackpot server dynamically adjusts the odds of triggering a jackpot in real-time, ensuring that players with longer win streaks are more to win larger prizes.

These steps differentiate this system from traditional jackpot models by emphasizing player performance and skill as factors in jackpot determination, rather than relying solely on random chance or wager size.

### 35 USC 101 Considerations:

This innovative concept provides a concrete improvement over traditional jackpot systems by incorporating player performance as a determining factor for jackpot rewards. The system solves the problem of static jackpot odds by introducing dynamic adjustments based on consecutive player wins, offering a more interactive and skill-based approach to jackpot determination.

This technical solution integrates real-time performance tracking and dynamic jackpot adjustments into DETG systems, going beyond abstract ideas to provide a tangible improvement in casino gaming functionality. The use of win streaks to influence jackpot outcomes represents a novel and patent-eligible advancement in gaming technology.

### Data Input:

The system collects data on player performance, specifically tracking consecutive wins across multiple game sessions. Additional data inputs include player wagers, game outcomes, and session duration, which are used to calculate the jackpot boosts and odds adjustments.

### Component Interactions and Procedural Steps:

1. Win Streak Tracking: The system monitors each player's consecutive wins across all DETGs, updating the win streak tracker with real-time data.
2. Jackpot Odds Adjustment: The jackpot server dynamically adjusts the jackpot odds based on the player's win streak, increasing the likelihood of a payout as the streak lengthens.
3. Player Notification: The ETGT notifies players of their current win streak and how it affects their jackpot potential, encouraging them to continue playing.

### Data Processing:

The system processes data on player win streaks to calculate dynamic adjustments to the jackpot odds. The jackpot server continuously updates the odds based on real-time data, ensuring that players with longer streaks have a higher probability of triggering a jackpot.

### Outputs and Responses:

The primary output is the real-time adjustment of jackpot odds, which is communicated to players through the ETGT. Players receive feedback on their win streak and the associated jackpot boost, enhancing their overall gameplay experience.

### Data Storage and Reporting:

The system stores data on player win streaks, game outcomes, and jackpot contributions. This data is used for audit purposes and to track player performance over time, ensuring transparency in the jackpot system.

### Error Handling and Security Measures:

Error handling mechanisms ensure that win streaks are accurately tracked and that jackpot odds are properly adjusted based on real-time data. Security measures protect the integrity of the win streak tracking system and prevent manipulation of game outcomes.

### End of Interaction:

Once a jackpot is triggered or a win streak is broken, the system resets the player's win streak data, and the process begins anew for the next game session. Players are notified of the final jackpot outcome, and the system prepares for the next potential win streak.

### Innovative Concept 61—Multi-Level Jackpot Tiers Based on Player Activity Across Multiple DETGs

### Identification of Concept:

This innovative concept introduces a multi-tiered jackpot system that dynamically adjusts based on the activity of individual players across multiple Dealer-controlled Electronic Table Games (DETGs). Players who engage with the casino's DETG network over extended periods are eligible for different jackpot tiers, where higher activity levels unlock larger jackpot pools or more frequent jackpot triggers. The more games or sessions a player participates in, the higher their position within the jackpot tiers. This system provides additional incentives for frequent play and extended engagement, rewarding loyal players with progressively larger jackpot opportunities.

Players' activity levels—such as total wagers, time spent playing, or consecutive games—are monitored, and the system automatically adjusts their tier status. This allows players to work toward unlocking larger jackpot pools by staying engaged with the DETG network, thus fostering greater player retention.

### Sequence Diagram Components:

Electronic Table Game Terminals (ETGTs): Display real-time information about each player's current jackpot tier status, tracking their activity across multiple DETGs. They notify players when they move up a tier and provide updates on jackpot conditions.
Casino Network: Tracks player activity levels across all connected DETGs, determining tier status based on predefined criteria such as wagers placed, time spent, or games played. It communicates this data to the jackpot server.
Jackpot Server: Manages the multi-tier jackpot system, ensuring that players in higher tiers have access to larger or more frequent jackpots. The server adjusts jackpot probabilities and pools dynamically based on player tier.
Players A, B, C: Players participating in games across multiple DETGs, who move up through the jackpot tiers as they increase their activity levels.
Activity Tracker: A backend system component that continuously monitors player engagement, tracking their progress toward unlocking higher jackpot tiers.

### Implementation Details:

The multi-tier jackpot system is integrated into the casino network, with each player's activity being tracked across all DETGs. The system monitors various factors, such as total wagers placed, the number of games played, or the duration of gameplay sessions. As players meet certain thresholds, they are promoted to higher jackpot tiers, where they are eligible for larger or more frequent jackpot triggers.

The jackpot server manages this multi-tiered system by dynamically adjusting the jackpot pools and trigger probabilities based on each player's tier. For example, a player in Tier 1 may have a smaller jackpot pool with infrequent triggers, while a player in Tier 3 may have access to a significantly larger jackpot pool with more frequent triggers. The ETGTs provide real-time feedback to players, notifying them when they move up a tier and updating them on their current jackpot potential.

The activity tracker is responsible for monitoring all relevant player data and determining when players qualify for a tier promotion. This system encourages continuous engagement, as players know that the more they play, the greater their jackpot rewards.

### Example Walk-Through Scenario:

Player A starts their day by playing several rounds of blackjack at one DETG. After playing 15 rounds and placing a series of wagers, Player A's activity tracker logs enough gameplay to promote them from Tier 1 to Tier 2. The ETGT immediately notifies Player A of their promotion, informing them that they now have access to a larger jackpot pool.

Meanwhile, Player B has been playing across multiple DETGs, including baccarat and roulette, for several hours. The system tracks Player B's total wagers and games played, eventually promoting them to Tier 3. The ETGT updates Player B in real-time, showing that they are now eligible for significantly larger jackpots with more frequent trigger opportunities.

As Player A and Player B continue playing, they notice that their chances of hitting a jackpot have increased due to their higher tier status. Eventually, Player B triggers a large Tier 3 jackpot during a roulette game, while Player A, who is still in Tier 2, continues working toward their next tier promotion.

### Player Interaction:

Players interact with this system by simply engaging in normal gameplay. As they play more rounds or place higher wagers, they move up through the jackpot tiers, which are tracked and displayed on their ETGTs. Players are notified in real-time when they advance to a higher tier, giving them instant feedback and encouraging them to keep playing to unlock greater rewards.

This interaction is seamless, as the system tracks player activity in the background and automatically adjusts jackpot eligibility. The tier-based rewards system keeps players motivated to continue playing, knowing that the more they engage, the better their chances of winning larger jackpots.

### Distinguishing Innovative Concepts:

This concept introduces a multi-level jackpot system based on player activity, which is a significant departure from conventional jackpot systems that rely solely on random triggers or wager size. By tying jackpot tiers to player engagement, this system rewards loyalty and encourages extended play, creating a more dynamic and interactive gaming experience.

The ability to progress through jackpot tiers based on activity levels adds a sense of progression and achievement for players, making the gaming experience more rewarding over time. This multi-tier system also allows casinos to better incentivize high rollers and frequent players by offering larger rewards based on their loyalty and engagement.

### Distinguishing Inventive Steps:

1. Activity-Based Tier Promotion: The system tracks player activity across multiple DETGs and promotes them to higher jackpot tiers as they meet predefined thresholds, creating a direct link between engagement and rewards.
2. Dynamic Jackpot Pool Adjustment: The jackpot server adjusts the size of the jackpot pools and the frequency of jackpot triggers based on each player's current tier, ensuring that higher-tier players are eligible for larger or more frequent jackpots.
3. Real-Time Tier Feedback: Players receive real-time updates on their current tier status and jackpot eligibility, keeping them informed of their progress and encouraging them to continue playing.

These steps distinguish this system from traditional jackpot models by introducing a multi-tier structure that rewards player loyalty and engagement.

### 35 USC 101 Considerations:

This innovative concept provides a concrete improvement over traditional jackpot systems by integrating player activity as a determining factor for jackpot tiers and rewards. The system solves the problem of static jackpot odds by introducing dynamic adjustments based on player engagement, offering a more interactive and rewarding experience.

This technical solution goes beyond abstract ideas by providing a real-time, practical application that enhances the functionality of DETG systems. The use of multi-tiered jackpots based on player activity represents a novel and patent-eligible advancement in gaming technology, offering casinos a new way to incentivize frequent play.

### Data Input:

The system collects data on player activity, including wagers placed, games played, and session duration. This data is used to calculate each player's tier status and determine their eligibility for larger or more frequent jackpots. Players are also notified when they reach new tiers.

### Component Interactions and Procedural Steps:

1. Activity Tracking: The system tracks each player's activity across multiple DETGs, updating their tier status based on predefined thresholds for engagement.
2. Jackpot Tier Promotion: When a player meets the criteria for a tier promotion, the jackpot server adjusts their jackpot eligibility, increasing their odds of triggering larger rewards.
3. Real-Time Feedback: The ETGT provides real-time feedback to players, notifying them of their tier promotion and updating their jackpot potential.

### Data Processing:

The system processes data on player activity to calculate tier promotions and adjust jackpot eligibility. The jackpot server dynamically updates the odds and jackpot pools based on each player's tier, ensuring that higher-tier players have a greater chance of winning larger prizes.

### Outputs and Responses:

The primary output is the real-time feedback provided to players through their ETGTs, informing them of their current tier status and jackpot eligibility. The system also dynamically adjusts the jackpot odds and pool size based on player activity.

### Data Storage and Reporting:

The system stores data on player activity, tier promotions, and jackpot contributions for audit and reporting purposes. This data is used to track player engagement and ensure transparency in the jackpot system.

### Error Handling and Security Measures:

Error handling mechanisms ensure that player activity is accurately tracked and that tier promotions are properly awarded. Security measures protect the integrity of the tier-based jackpot system, preventing manipulation of player data or tier status.

### End of Interaction:

Once a jackpot is triggered, the system resets the player's tier-based jackpot eligibility, and the process begins anew for the next game session. Players are notified of the final results, and the system continues tracking activity for future tier promotions.

### Innovative Concept 62—Time-Limited Jackpot Opportunities Triggered by Inactivity at Specific DETGs

### Identification of Concept:

This innovative concept introduces a feature where time-limited jackpot opportunities are triggered if specific Dealer-controlled Electronic Table Games (DETGs) experience prolonged periods of inactivity. If a DETG is left idle for a predetermined period, the system will initiate a “jackpot opportunity” designed to incentivize players to engage with that particular table. The jackpot opportunity may be time-sensitive, with a countdown displayed on the ETGT screen, encouraging players to participate before the opportunity expires. This feature is intended to ensure constant activity across multiple DETGs within the casino, maximizing engagement and reducing downtime at any given table.

The system automatically monitors player engagement across all DETGs, and when it detects that a specific table has not been active for a defined time (e.g., 15 minutes), it triggers the jackpot opportunity. This may take the form of enhanced jackpot odds, a guaranteed prize for the next player to participate, or a bonus added to the jackpot pool.

### Sequence Diagram Components:

Electronic Table Game Terminals (ETGTs): Display countdown timers and notifications for time-limited jackpot opportunities. Players receive real-time updates when these opportunities are triggered due to inactivity.
Casino Network: Tracks player engagement and inactivity across all connected DETGs, identifying which tables qualify for time-limited jackpot opportunities based on inactivity thresholds.
Jackpot Server: Manages the jackpot pool and adjusts jackpot triggers when a table becomes eligible for a time-limited opportunity, ensuring that the next player to engage has increased jackpot potential.
Players A, B, C: Players who interact with the ETGTs and are notified of the jackpot opportunities when specific tables become idle.
Inactivity Tracker: A backend system component that monitors inactivity at each DETG and triggers jackpot opportunities when inactivity thresholds are met.

### Implementation Details:

The system is designed to track player engagement at each DETG. When the inactivity tracker detects that a table has been idle for a predefined period (e.g., 15 minutes without any wagers placed), the system triggers a time-limited jackpot opportunity. This opportunity is communicated to all nearby ETGTs, encouraging players to return to the idle table before the opportunity expires.

The jackpot server dynamically adjusts the jackpot triggers based on the type of opportunity being offered. For example, the first player to place a wager at the idle table may receive a boosted chance of winning the jackpot, or the next jackpot trigger at that table may be guaranteed within the next few rounds.

The system may also offer different types of incentives depending on how long the table has been inactive. For shorter periods of inactivity, the system may offer a modest jackpot boost, while longer periods of inactivity may result in larger rewards to entice players back to the table.

### Example Walk-Through Scenario:

Player A is playing blackjack at a DETG while Player B is at a nearby baccarat table. The casino network detects that a nearby roulette table has been inactive for 20 minutes. The inactivity tracker triggers a time-limited jackpot opportunity at the roulette table, and Player A's ETGT displays a notification that the table has an enhanced jackpot opportunity available for the next 10 minutes.

Player A decides to take advantage of this opportunity, leaving their blackjack game to place a wager at the roulette table. As soon as Player A places their bet, the system adjusts the jackpot odds for that table, increasing Player A's chance of hitting the mystery jackpot. Player B, who is also alerted to the opportunity, joins the roulette table, increasing the overall activity.

Before the timer runs out, Player A hits the enhanced jackpot, benefiting from the time-limited opportunity that was triggered by the table's inactivity. The system resets the table's status and resumes normal jackpot conditions once the opportunity has expired.

### Player Interaction:

Players interact with the system through their ETGTs, which notify them of any time-limited jackpot opportunities at nearby tables. The notifications include a countdown timer and information about the type of opportunity available, encouraging players to move to the idle table and place a wager before the opportunity expires.

This feature incentivizes players to explore different games within the casino and prevents tables from remaining idle for extended periods, thus maintaining consistent activity across all DETGs.

### Distinguishing Innovative Concepts:

This concept introduces a dynamic way of reducing inactivity at DETGs by offering time-limited jackpot opportunities. Unlike traditional jackpot systems, which rely on random triggers or player participation alone, this system uses inactivity as a trigger to create an incentive for players to engage with underutilized tables. The time-sensitive nature of the opportunity adds urgency, motivating players to act quickly to take advantage of the enhanced jackpot conditions.

This approach ensures that all DETGs remain active, maximizing casino revenue and providing players with unique, time-limited rewards that add excitement to the gaming experience.

### Distinguishing Inventive Steps:

1. Inactivity-Based Jackpot Trigger: The system monitors inactivity at DETGs and triggers jackpot opportunities when a table remains idle for a predefined period.
2. Time-Limited Opportunities: The system introduces time-sensitive rewards, such as enhanced jackpot odds or guaranteed prizes, encouraging players to engage with idle tables before the opportunity expires.
3. Dynamic Jackpot Adjustment: The jackpot server dynamically adjusts the odds and rewards based on the length of inactivity, offering progressively larger incentives for tables that have been idle for longer periods.

These steps distinguish this system from conventional jackpot models by creating an incentive for players to re-engage with idle tables, ensuring continuous activity and reducing downtime across the DETG network.

### 35 USC 101 Considerations:

This innovative concept provides a concrete improvement over traditional jackpot systems by introducing a dynamic, time-sensitive mechanism for re-engaging players with inactive tables. The system solves the problem of idle DETGs by offering real-time incentives, enhancing player engagement and reducing downtime.

This technical solution goes beyond an abstract idea by providing a practical, real-time application that adjusts jackpot conditions based on inactivity. The use of time-limited jackpot opportunities represents a novel, patent-eligible advancement in DETG gaming technology, offering casinos a new way to manage table activity and player engagement.

### Data Input:

The system collects data on player activity and inactivity across all DETGs. When a table remains idle for a certain period, the inactivity tracker triggers a jackpot opportunity. Players may also input data by choosing to engage with the idle table, which resets the inactivity status and activates the enhanced jackpot conditions.

### Component Interactions and Procedural Steps:

1. Inactivity Monitoring: The inactivity tracker monitors each DETG for player engagement and triggers a jackpot opportunity when a table becomes idle.
2. Time-Limited Notification: The system notifies players of the opportunity through their ETGTs, displaying a countdown timer and information about the enhanced jackpot conditions.
3. Jackpot Adjustment: The jackpot server adjusts the jackpot odds or pool based on the type of opportunity triggered, ensuring that players who engage with the idle table are rewarded.

### Data Processing:

The system processes data on table inactivity and dynamically adjusts the jackpot conditions based on the length of time the table has been idle. The jackpot server continuously updates the odds and rewards in real-time, providing players with accurate information on the time-limited opportunity.

### Outputs and Responses:

The primary outputs include real-time notifications displayed on the ETGTs, informing players of time-limited jackpot opportunities. The system also adjusts the jackpot conditions in response to player engagement with idle tables, ensuring that the rewards are distributed accordingly.

### Data Storage and Reporting:

The system stores data on table inactivity, player engagement, and jackpot outcomes for audit and reporting purposes. This data is used to track player behavior and optimize the time-limited jackpot system for future use.

### Error Handling and Security Measures:

Error handling mechanisms ensure that inactivity is accurately tracked and that jackpot opportunities are properly triggered and awarded. Security measures protect the integrity of the system, preventing manipulation of inactivity data or jackpot conditions.

### End of Interaction:

Once a player engages with an idle table and the jackpot opportunity is triggered, the system resets the inactivity tracker and returns the table to normal jackpot conditions. The process repeats when a new period of inactivity is detected.

Innovative Concept 63—Real-Time Progressive Jackpot Contributions from Concurrent Game Rounds at Multiple DETGs

### Identification of Concept:

This innovative concept enables real-time progressive jackpot contributions from multiple game rounds occurring concurrently at different Dealer-controlled Electronic Table Games (DETGs) across the casino network. Each game round played at the DETGs, such as blackjack, roulette, or baccarat, contributes a portion of the players' wagers to a shared progressive jackpot pool. The system continuously monitors active game rounds, automatically calculating and distributing a percentage of wagers to the jackpot pool. As more games are played concurrently, the jackpot pool grows faster, increasing the potential prize for the next jackpot winner. This approach keeps the jackpot dynamic and exciting, encouraging higher player participation across different DETGs, as they all contribute to the same cumulative jackpot.

The progressive jackpot is shared across multiple games and tables, providing an exciting element of cross-game competition, as players from different DETGs compete for the same jackpot. This feature ensures that the jackpot pool is constantly growing, regardless of which DETG players are engaging with, thus maximizing player engagement across the entire casino floor.

### Sequence Diagram Components:

Electronic Table Game Terminals (ETGTs): Players interact with ETGTs to place their wagers. A portion of these wagers is automatically contributed to the shared progressive jackpot pool. The ETGTs also display real-time updates on the current jackpot value.
Casino Network: Tracks all wagers placed across the network of DETGs, calculating and allocating the percentage of each bet that contributes to the jackpot pool. It synchronizes this data across the network to ensure that all ETGTs display the correct, updated jackpot value.
Jackpot Server: Manages the shared progressive jackpot pool, receiving contribution data from each DETG and updating the total jackpot amount. The server triggers the jackpot payout when a winning condition is met.
Players A, B, C (Different DETGs): Players at various DETGs who place wagers, each contributing to the progressive jackpot. These players may be playing different games, but their wagers collectively increase the jackpot pool.
Wager Contribution System: A backend system responsible for calculating the percentage of each wager that is allocated to the jackpot pool, ensuring that all contributions are accurately processed in real-time.

### Implementation Details:

The real-time progressive jackpot system is integrated into the casino network, with all DETGs contributing a percentage of player wagers to a shared jackpot pool. The system continuously monitors each game round, calculating the appropriate percentage of each wager to allocate to the progressive jackpot. This percentage may be adjusted based on the type of game or wager, allowing the casino to fine-tune the jackpot's growth rate.

The jackpot server consolidates the contributions from all active DETGs, ensuring that the jackpot pool reflects the total contributions in real-time. As players place bets on different DETGs, the system updates the jackpot value, which is displayed on all ETGTs across the casino. This provides players with a live view of the growing jackpot, increasing the excitement and encouraging more participation.

The system also allows for the progressive jackpot to be triggered by any qualifying event on any DETG within the network. Once the jackpot is triggered, the system immediately calculates the payout based on the rules of the specific game being played, ensuring that the winnings are distributed appropriately.

### Example Walk-Through Scenario:

Player A is playing blackjack at a live dealer-controlled table, while Player B is playing roulette, and Player C is engaged in baccarat. As each player places wagers, the system automatically deducts a small percentage from their bets to contribute to the shared progressive jackpot pool. The contributions are processed in real-time, with the jackpot server updating the total jackpot value across all DETGs.

As the players continue their rounds, the jackpot value steadily increases, with contributions flowing in from each player's wager. Player A wins a hand of blackjack, but the jackpot is not triggered. Meanwhile, the system continues to accept contributions from Player B and Player C's wagers.

Later in the evening, Player C hits a rare winning hand in baccarat, triggering the shared progressive jackpot. The jackpot server calculates the total prize and distributes it to Player C, while resetting the jackpot pool for the next round of contributions.

### Player Interaction:

Players interact with the system seamlessly as part of their normal gameplay. They place their wagers on the ETGTs, and a portion of each bet is automatically contributed to the progressive jackpot pool without any additional input required. The ETGTs display real-time updates on the jackpot's current value, allowing players to see the direct impact of their contributions as the jackpot grows.

The system adds excitement to the gaming experience, as players across different DETGs feel connected by the shared goal of triggering the jackpot. The opportunity to contribute to and win a progressively growing jackpot incentivizes continuous play, as players know that each wager brings them closer to a potentially life-changing prize.

### Distinguishing Innovative Concepts:

This concept distinguishes itself by creating a shared progressive jackpot that spans multiple DETGs and different types of games. Unlike traditional jackpot systems that are limited to a single game or table, this system integrates contributions from multiple sources, allowing the jackpot pool to grow faster and engage more players across the casino. The real-time contribution system adds excitement by ensuring that players from different games are all working toward the same jackpot, creating a sense of shared anticipation and competition.

This system also ensures that all contributions are processed in real-time, providing players with instant feedback on the growing jackpot value. This dynamic approach keeps players engaged and encourages them to continue playing across multiple game rounds and sessions.

### Distinguishing Inventive Steps:

1. Cross-Game Progressive Jackpot Contribution: The system allows multiple DETGs, each hosting different games, to contribute to the same progressive jackpot pool, increasing the overall excitement and engagement across the casino.
2. Real-Time Wager Tracking and Contribution: The system processes wager contributions in real-time, updating the jackpot pool instantly as bets are placed, ensuring players see immediate feedback on the growing jackpot.
3. Dynamic Jackpot Distribution: The system allows for the progressive jackpot to be triggered by any qualifying event across the network of DETGs, ensuring that players from different games all have a chance to win the shared jackpot.

These steps differentiate this system from conventional jackpot models by introducing a cross-game, real-time progressive jackpot that encourages broader participation and higher engagement across the casino.

### 35 USC 101 Considerations:

This innovative concept provides a concrete improvement over traditional progressive jackpot systems by integrating multiple DETGs into a shared, real-time jackpot pool. The system solves the problem of limited jackpot growth by allowing contributions from multiple games, significantly increasing the potential jackpot size and player engagement.

The technical implementation of real-time wager tracking and dynamic jackpot contributions goes beyond abstract ideas, providing a practical solution that enhances the functionality of DETG systems. The cross-game progressive jackpot mechanism represents a novel, patent-eligible advancement in gaming technology, offering casinos a more engaging and profitable way to manage progressive jackpots.

### Data Input:

The system collects data on player wagers across multiple DETGs. Each wager is processed to calculate the percentage that will be contributed to the progressive jackpot pool. The system also tracks the current jackpot value and updates it in real-time as new contributions are made.

### Component Interactions and Procedural Steps:

1. Wager Processing: The system calculates the contribution from each wager placed at the DETGs, ensuring that the correct percentage is allocated to the jackpot pool.
2. Jackpot Pool Update: The jackpot server updates the progressive jackpot value in real-time, ensuring that all DETGs display the correct total.
3. Jackpot Trigger and Payout: When a qualifying event occurs, the system triggers the jackpot payout, calculating the prize based on the current jackpot pool and distributing the winnings accordingly.

### Data Processing:

The system processes data on player wagers and updates the jackpot pool in real-time. The progressive jackpot server continuously monitors the contributions from each DETG, ensuring that the jackpot grows dynamically as more players place wagers.

### Outputs and Responses:

The primary output is the updated jackpot value displayed on the ETGTs, providing players with real-time feedback on the growing jackpot. The system also processes and distributes the jackpot payout when triggered, ensuring that the winnings are accurately calculated and delivered to the qualifying player.

### Data Storage and Reporting:

The system stores data on wager contributions, jackpot triggers, and payouts. This data is used for audit and reporting purposes, ensuring transparency in the jackpot system and providing insights into player engagement across multiple DETGs.

### Error Handling and Security Measures:

Error handling ensures that wager contributions are accurately processed and that the jackpot value is correctly updated. Security measures protect the integrity of the progressive jackpot system, preventing unauthorized access or manipulation of the jackpot pool.

### End of Interaction:

Once the jackpot is triggered and the winnings are distributed, the system resets the jackpot pool and begins accumulating contributions for the next round. Players are notified of the jackpot outcome, and the process continues as new wagers are placed across the DETGs.

### Innovative Concept 64—Jackpot Participation Triggered by Player Achievements in Game-Integra Ted Challenges

### Identification of Concept:

This innovative concept introduces the idea of integrating game-specific challenges into the gameplay of Dealer-controlled Electronic Table Games (DETGs) that reward players with jackpot participation when they accomplish specific achievements. For example, completing certain in-game objectives-such as hitting a certain number of consecutive wins, reaching a designated high score, or winning with particular card combinations—may make players eligible for a mystery jackpot or boost their jackpot odds. These achievements act as milestones, adding a competitive and engaging element to the gaming experience.

The achievements may be specific to each type of game (e.g., blackjack, roulette, or baccarat) and dynamically updated based on real-time game data. Players are encouraged to complete these challenges, which are displayed on their Electronic Table Game Terminals (ETGTs) as part of the overall jackpot system. This dynamic adds a new layer of interaction, blending skill-based and objective-based gameplay with the chance of triggering a jackpot, keeping players engaged over longer sessions.

### Sequence Diagram Components:

Electronic Table Game Terminals (ETGTs): Players interact with these terminals to view current challenges, their progress toward completing them, and their jackpot eligibility. The ETGTs also display real-time updates on when challenges are completed and how they affect jackpot chances.
Casino Network: Monitors player progress toward completing game-specific challenges and communicates this data to the jackpot server. The network also tracks which players are eligible for jackpot participation based on their achievements.
Jackpot Server: Manages the jackpot pool and adjusts participation and odds based on the completion of specific challenges. It dynamically increases jackpot participation and potential for players who meet in-game objectives.
Player A, B, C (across different games): Players who complete specific in-game challenges, earning eligibility for jackpot participation or enhanced odds in the mystery jackpot.
Achievement Tracker: A backend system that logs player achievements in real-time, determining when players are eligible for jackpot participation and communicating this data to the jackpot server.

### Implementation Details:

The system monitors player achievements during gameplay, tracking performance-based objectives such as consecutive wins, achieving specific game conditions, or completing strategic moves. The achievements are tailored to each game type, such as blackjack, where players may need to win a hand with a certain card combination, or baccarat, where completing a certain number of successful hands in a row may trigger jackpot eligibility.

Once a player completes an achievement, the ETGT immediately notifies them of their eligibility for jackpot participation. The jackpot server dynamically adjusts their odds based on the achievement type and the overall pool. For example, minor achievements may result in a smaller jackpot chance, while major achievements may significantly boost their odds of triggering a jackpot.

This real-time feedback keeps players engaged, as they may see their progress toward achieving various milestones. The casino network and achievement tracker work together to monitor all player activity, ensuring that the data is updated instantly and the jackpot potential reflects the player's accomplishments.

### Example Walk-Through Scenario:

Player A is playing roulette at a live dealer-controlled table, working toward a challenge that may require winning five consecutive rounds. Meanwhile, Player B is engaged in a blackjack game where the challenge is to achieve a hand consisting of two face cards and an Ace. As both players continue through their respective games, the system tracks their progress toward completing these challenges.

After winning five rounds in a row, Player A's ETGT immediately informs them that they are now eligible for the mystery jackpot, boosting their odds in the next game round. Player B, on the other hand, achieves their card combination and is also notified of their new jackpot eligibility.

Both players now have enhanced jackpot participation, and the excitement grows as they continue playing, knowing that their recent achievements have increased their chances of triggering a jackpot.

### Player Interaction:

Players interact with the system by attempting to complete game-specific challenges displayed on their ETGTs. These challenges are updated in real-time based on their gameplay. Once a challenge is completed, the system automatically notifies the player of their jackpot eligibility and updates the odds accordingly.

This interaction enhances player engagement, as the achievement-based system adds an element of skill and strategy to the gaming experience. Players are encouraged to focus on completing objectives, which in turn increases their chances of winning a jackpot.

### Distinguishing Innovative Concepts:

This innovative concept introduces a dynamic and interactive way of engaging players by tying game achievements directly to jackpot participation. Unlike traditional systems that rely on random triggers or simple bet-based mechanics, this system rewards players for completing specific objectives, adding an element of skill and strategy to the jackpot process.

The integration of game-specific challenges also keeps the gameplay fresh and engaging, encouraging players to participate over longer periods as they work toward achieving different milestones. This creates a more immersive gaming experience, where players feel that their skill and effort may directly influence their chances of winning.

### Distinguishing Inventive Steps:

1. Achievement-Based Jackpot Eligibility: Players earn eligibility for jackpot participation by completing specific game-based challenges, adding a skill-based element to the jackpot system.
2. Dynamic Real-Time Odds Adjustment: The jackpot server dynamically adjusts the odds of winning based on the player's achievements, providing immediate feedback and enhancing player engagement.
3. Game-Specific Challenges: Each game offers unique challenges that are tailored to its mechanics, ensuring that the system remains versatile and engaging across multiple game types.

These steps distinguish this system from conventional jackpot models by introducing skill-based elements and real-time feedback, making the jackpot process more interactive and rewarding.

### 35 USC 101 Considerations:

This innovative concept provides a concrete improvement over traditional jackpot systems by incorporating skill-based challenges and dynamic odds adjustment. The system solves the problem of static jackpot triggers by rewarding players for completing specific in-game objectives, creating a more engaging and interactive experience.

This technical solution integrates real-time achievement tracking and dynamic jackpot adjustments into DETG systems, going beyond abstract ideas to provide a tangible improvement in casino gaming functionality. The use of achievement-based jackpot participation represents a novel and patent-eligible advancement in gaming technology.

### Data Input:

The system collects data on player performance, tracking specific achievements such as consecutive wins, card combinations, or other in-game milestones. Once a player completes an achievement, the system logs this data and adjusts their jackpot eligibility accordingly.

### Component Interactions and Procedural Steps:

1. Achievement Tracking: The system monitors each player's performance, tracking their progress toward completing specific game-based challenges.
2. Jackpot Eligibility Notification: Once a player completes an achievement, the system notifies them through their ETGT and adjusts their jackpot odds.
3. Dynamic Jackpot Odds Adjustment: The jackpot server adjusts the odds based on the type of achievement completed, increasing the player's chances of triggering a jackpot.

### Data Processing:

The system processes player performance data to determine when specific challenges are completed. The jackpot server dynamically adjusts the jackpot odds based on this data, providing real-time feedback to players through their ETGTs.

### Outputs and Responses:

The primary output is the notification provided to players when they complete an achievement, informing them of their new jackpot eligibility. The system also dynamically adjusts the jackpot odds, providing players with enhanced chances of winning based on their accomplishments.

### Data Storage and Reporting:

The system stores data on player achievements, challenge completion, and jackpot eligibility. This data is used for reporting purposes, allowing casinos to track player performance and adjust the challenge system for future use.

### Error Handling and Security Measures:

Error handling ensures that achievements are accurately tracked and that jackpot eligibility is properly awarded based on player performance. Security measures protect the integrity of the achievement-based jackpot system, preventing manipulation of challenge data.

### End of Interaction:

Once a player completes an achievement and receives jackpot eligibility, the system resets the challenge and provides new objectives for the next round of gameplay. Players are encouraged to continue playing to complete more challenges and further increase their jackpot potential.

### Innovative Concept 65—Time-Based Jackpot Expiry for Unclaimed Jackpots

### Identification of Concept:

This innovative concept introduces a mechanism where unclaimed jackpots from specific games or events within the Dealer-controlled Electronic Table Game (DETGs) system have an expiry period, after which they are redistributed or repurposed within the casino network. If a jackpot is triggered but not claimed within a set time, the system automatically redistributes the jackpot funds either to an alternative jackpot pool, for new player incentives, or as bonuses for existing games. This feature ensures that jackpots remain dynamic and time-sensitive, keeping players engaged and ensuring the casino has a system for handling unclaimed winnings.

This concept may enhance player motivation by adding urgency to claim jackpots while also enabling the casino to manage unclaimed funds efficiently. It prevents stagnation in jackpot pools and keeps the DETG network active, creating opportunities to repurpose expired jackpots into future gaming incentives.

### Sequence Diagram Components:

Electronic Table Game Terminals (ETGTs): Players interact with ETGTs, which display jackpot expiry notifications when a jackpot is triggered but unclaimed. The terminals allow players to claim jackpots within the designated time period.
Casino Network: Tracks unclaimed jackpots across all connected DETGs. Once a jackpot remains unclaimed beyond the set period, the network redistributes the funds.
Jackpot Server: Manages the expiry of jackpots, redistributing funds when necessary. It may also be configured to boost other jackpot pools or initiate bonus rounds using expired jackpots.
Players A, B, C: Players who interact with the ETGTs, either by winning jackpots or observing jackpot expiry periods. They are notified of opportunities to claim or earn redistributed jackpots.
Timer System: A backend component that monitors jackpot claim windows and triggers redistributions if the timer expires.

### Implementation Details:

This system monitors all jackpots across the DETG network, establishing time limits for players to claim their winnings. Once a jackpot is triggered, the system activates a countdown visible on the ETGTs. If the player who triggered the jackpot does not claim it within the set period (e.g., 10 minutes), the jackpot funds are marked for redistribution.

The system uses the casino network and jackpot server to automatically process expired jackpots. Redistribution may take several forms: the funds may be added to other existing jackpots, used to boost mystery jackpots, or allocated to specific player bonuses for future rounds. The ETGTs provide notifications and updates to all players, ensuring transparency about jackpot expiry and redistribution.

To implement this system, the casino may configure expiry times, distribution rules, and bonus allocation criteria within the jackpot server. Players are encouraged to claim their jackpots promptly, and the casino maintains control over unclaimed funds without manual intervention.

### Example Walk-Through Scenario:

Player A triggers a mystery jackpot while playing blackjack at a DETG but leaves the table before claiming the prize. The ETGT begins displaying a countdown timer, informing all nearby players that a jackpot remains unclaimed for a limited time. Player B notices the timer but does not intervene, as the jackpot may only be claimed by the original winner.

After the timer expires, the jackpot server automatically redistributes the unclaimed jackpot to other active games within the casino. The funds are split between a baccarat table's progressive jackpot and a bonus round for another group of players. Both Player A and Player B receive notifications of the jackpot expiry and redistribution.

Player C, who has been playing at a different table, is now informed that the next baccarat round has an increased jackpot due to the redistributed funds, encouraging further play.

### Player Interaction:

Players interact with the system primarily through notifications on their ETGTs. When a jackpot is triggered, the system alerts the player and other nearby terminals. If the jackpot remains unclaimed, the ETGT shows a countdown timer, adding a sense of urgency.

After the jackpot expiry, players are informed of how the unclaimed funds have been redistributed. They may then participate in new games with boosted jackpots or bonus opportunities, adding excitement and variety to the gaming experience.

### Distinguishing Innovative Concepts:

The notable distinction of this concept lies in the management of unclaimed jackpots. Conventional jackpot systems may leave unclaimed winnings inactive for extended periods, leading to inefficiencies. This concept introduces a dynamic, time-sensitive approach, where unclaimed jackpots are quickly repurposed for the benefit of other players and games, maintaining the fluidity and excitement of the gaming environment.

Additionally, this system ensures that jackpot pools are constantly evolving, creating new incentives and excitement for players, unlike static jackpots in traditional systems.

### Distinguishing Inventive Steps:

1. Time-Limited Jackpot Claim: The system tracks unclaimed jackpots and enforces a claim window, encouraging players to act quickly and claim their winnings.
2. Automatic Jackpot Redistribution: If a jackpot is not claimed within the set time, the system automatically redistributes the funds across other games, ensuring that jackpots remain active and impactful.
3. Dynamic Jackpot Notification: The ETGTs provide real-time notifications to all players about the status of jackpots, including expiry warnings and details on redistributed funds.

These steps differentiate this system from conventional jackpot models by introducing a time-sensitive mechanism for jackpot management and ensuring continuous engagement with evolving jackpot opportunities.

### 35 USC 101 Considerations:

This innovative concept provides a concrete improvement over traditional jackpot systems by introducing a method for efficiently managing unclaimed jackpots. The system solves the problem of stagnant, unclaimed jackpot pools by implementing a time-based expiry mechanism that dynamically redistributes funds, enhancing player engagement and casino revenue.

The technical solution integrates real-time jackpot tracking, countdown timers, and automatic fund redistribution, going beyond abstract ideas to deliver a practical and patent-eligible advancement in DETG systems. The concept offers an innovative way to manage jackpot flow and ensure continued excitement in casino environments.

### Data Input:

The system collects data on jackpot triggers, player activity, and the claim status of each jackpot. Once a jackpot is triggered, the timer system tracks the remaining claim period, and the casino network logs any unclaimed jackpots for redistribution.

### Component Interactions and Procedural Steps:

1. Jackpot Timer Activation: The system begins a countdown when a jackpot is triggered and unclaimed, alerting players of the remaining time to claim their prize.
2. Jackpot Expiry and Redistribution: If the jackpot remains unclaimed, the server automatically redistributes the funds across other jackpot pools or initiates bonus opportunities for players.
3. Notification and Update: Players receive notifications on their ETGTs about the jackpot expiry and any redistributed funds, encouraging continued gameplay.

### Data Processing:

The system processes jackpot data to track claim status and trigger the expiry timer. The casino network and jackpot server handle the redistribution of unclaimed jackpots, ensuring that all games are updated with the new jackpot allocations in real-time.

### Outputs and Responses:

The primary output is the notification displayed on the ETGTs, informing players of jackpot expiries and redistributed funds. The system dynamically adjusts the jackpot pools and bonus rounds based on the expiry data, ensuring continued excitement and engagement.

### Data Storage and Reporting:

The system stores data on triggered, claimed, and expired jackpots. This data is used for reporting purposes, ensuring transparency in the redistribution process and allowing the casino to analyze player behavior and jackpot performance.

### Error Handling and Security Measures:

Error handling ensures that jackpots are properly tracked and redistributed when necessary. Security measures protect the integrity of the jackpot system, preventing tampering with expiry timers or jackpot funds.

### End of Interaction:

Once a jackpot is redistributed, the system resets the jackpot status for the original game, and players are notified of the redistribution outcome. The system prepares for the next jackpot event, ensuring continued engagement with the dynamic jackpot environment.

### Innovative Concept 66—Jackpot Contribution Tied to Game Outcome Across Multiple DETGs

### Identification of Concept:

This innovative concept proposes a jackpot system where the contribution to a shared jackpot pool is dynamically adjusted based on the outcome of individual game rounds across multiple Dealer-controlled Electronic Table Games (DETGs). For instance, certain game outcomes such as a win by the dealer in blackjack, a specific player result in baccarat, or a rare combination in roulette, contribute a percentage of the round's total wagers to the jackpot pool. This approach ties player results directly to the growth of the jackpot, adding more excitement to the outcomes and ensuring jackpot pools grow dynamically based on gameplay.

The notable feature is that this contribution mechanism is applied uniformly across all DETGs, meaning that players are contributing to the jackpot whether they win or lose, with specific game outcomes offering a higher contribution percentage. This offers an interactive experience where the growth of the jackpot is directly tied to game performance.

### Sequence Diagram Components:

Electronic Table Game Terminals (ETGTs): Track game results and notify players of the contribution to the jackpot based on the outcome. These terminals also display the current jackpot value and update in real time.
Casino Network: Monitors game outcomes across the entire DETG network, adjusting the percentage of contributions made to the shared jackpot pool.
Jackpot Server: Receives contribution data from each DETG and manages the shared jackpot pool, adjusting the contribution rate based on the game outcome criteria.
Players A, B, C: Players participate in different games, with their results impacting the jackpot pool. Certain outcomes (e.g., winning with a rare card combination) result in a larger contribution to the jackpot.
Game Outcome Monitor: A backend system that tracks all game results in real time, determining the contribution rate to the jackpot pool based on pre-set rules.

### Implementation Details:

In this system, the outcome of every game round is automatically monitored by the casino network, which adjusts the jackpot contribution rate based on the results. For instance, if a player in blackjack wins with a specific rare hand (such as a perfect pair), a larger percentage of the total wager is contributed to the jackpot pool. Similarly, if a dealer wins a round in baccarat, a smaller contribution is made, reflecting the less rare outcome.

The contribution percentages may be adjusted based on the casino's needs. A basic win by a player or dealer may contribute 1% of the wager to the jackpot pool, while a rare outcome like a perfect pair or hitting a specific number in roulette may contribute 5% or more. The ETGTs notify players when their results contribute to the jackpot pool, enhancing player engagement.

The jackpot server receives continuous updates on game results, ensuring that the jackpot pool grows dynamically based on gameplay across multiple DETGs. This creates an exciting, interactive experience where players are constantly aware that their results are impacting the overall jackpot growth.

### Example Walk-Through Scenario:

Player A is playing blackjack and receives a rare hand combination-a pair of Aces. The game outcome monitor logs this as a jackpot-worthy result, and the ETGT informs Player A that a portion of the total wager will contribute to the shared jackpot pool. Simultaneously, Player B, who is playing baccarat, wins a hand with a typical outcome, contributing a smaller percentage to the jackpot pool.

As the round concludes, the system updates the jackpot pool, reflecting contributions from both Player A's rare hand and Player B's regular win. The ETGTs display the new jackpot total in real time, showing the players how their individual results are impacting the larger jackpot pool.

### Player Interaction:

Players are informed of the jackpot contribution tied to their game results through real-time updates on the ETGTs. When a player wins with a rare hand or triggers a specific outcome, the system notifies them that a larger portion of their wager is contributing to the jackpot pool. This interactive element keeps players engaged, as they may see how their results are directly affecting the shared jackpot.

The jackpot system adds a layer of excitement to each game round, as players know that their performance may contribute more significantly to the overall jackpot if they achieve certain outcomes. This interaction incentivizes continued gameplay, as players are motivated to hit the rare combinations that lead to larger contributions.

### Distinguishing Innovative Concepts:

This concept distinguishes itself by linking jackpot contributions directly to game outcomes, rather than relying solely on random triggers or bet-based contributions. By tying the jackpot pool's growth to specific results, the system creates a dynamic, engaging environment where players feel more in control of the jackpot's development.

Additionally, this system allows the casino to fine-tune contribution rates based on game outcomes, ensuring that the jackpot pool grows in a balanced manner across all DETGs.

### Distinguishing Inventive Steps:

1. Outcome-Based Contribution Rates: The contribution to the jackpot pool is adjusted dynamically based on specific game outcomes, ensuring that rarer results contribute more to the jackpot.
2. Real-Time Jackpot Updates: The ETGTs provide real-time updates to players, informing them of how their results are impacting the jackpot pool, keeping them engaged and excited.
3. Cross-Game Contribution: This system applies across all DETGs, meaning that players from different games contribute to the same jackpot pool, fostering a sense of competition and shared excitement.

These steps differentiate this system from conventional jackpot models by making jackpot contributions outcome-dependent and creating an interactive, multi-game experience.

### 35 USC 101 Considerations:

This innovative concept provides a concrete improvement over traditional jackpot systems by introducing an outcome-based contribution mechanism. The system solves the problem of static, bet-based contributions by tying the jackpot pool's growth to the specific results of each game round, creating a more engaging and dynamic experience for players.

The technical implementation of real-time result tracking and dynamic contribution adjustments goes beyond abstract ideas, providing a practical solution that enhances the functionality of DETG systems. The concept offers a novel, patent-eligible advancement in gaming technology, providing a more interactive way to manage jackpot pools.

### Data Input:

The system collects data on game outcomes across multiple DETGs, using this data to determine the contribution rate for each round. Players' results are tracked in real time, with the jackpot contribution percentage adjusted based on predefined criteria.

### Component Interactions and Procedural Steps:

1. Game Outcome Tracking: The system monitors the results of each game round, determining whether a specific outcome qualifies for an increased contribution to the jackpot pool.
2. Jackpot Contribution Calculation: Based on the game outcome, the system calculates the percentage of the total wager to contribute to the jackpot pool, ensuring that rarer outcomes contribute more.
3. Real-Time Jackpot Update: The jackpot server updates the pool in real time, ensuring that players see immediate feedback on the jackpot's growth.

### Data Processing:

The system processes game outcome data to determine the contribution percentage for each round. The contribution is then added to the jackpot pool, which is updated across all DETGs in real time. This ensures that players receive immediate feedback on the impact of their results.

### Outputs and Responses:

The primary output is the updated jackpot total, displayed on the ETGTs. Players are also notified when their results contribute to the jackpot pool, keeping them informed and engaged. The system dynamically adjusts the contribution rate based on game outcomes.

### Data Storage and Reporting:

The system stores data on game outcomes, jackpot contributions, and player results. This data is used for reporting purposes, allowing the casino to analyze the performance of the jackpot system and player behavior.

### Error Handling and Security Measures:

Error handling ensures that game outcomes are accurately tracked and that jackpot contributions are properly calculated. Security measures protect the integrity of the system, preventing manipulation of game results or jackpot funds.

### End of Interaction:

Once a round is completed and the contribution is made to the jackpot pool, the system resets for the next game round. Players are notified of the updated jackpot total, and the process continues, ensuring continuous engagement with the evolving jackpot pool.

### Innovative Concept 67—Jackpot Odds Automatically Adjust Based on Bet Frequency

### Identification of Concept:

This innovative concept introduces dynamic jackpot odds that adjust automatically based on a player's bet frequency at Dealer-controlled Electronic Table Games (DETGs). The more frequently a player places bets, the higher their chances of triggering a jackpot. This concept allows for a player-centric adjustment, where consistent engagement with the game improves the player's odds over time, adding a strategic layer to gameplay. For example, if a player bets consecutively without skipping rounds or maintains a certain wager size, their probability of winning a mystery jackpot is incrementally increased.

By rewarding frequent engagement, the casino benefits from longer play sessions and increased betting activity, while players are incentivized to stay engaged by the prospect of enhanced odds over time.

### Sequence Diagram Components:

Electronic Table Game Terminals (ETGTs): Track the bet frequency of each player and display the current jackpot odds. These terminals provide real-time feedback, showing how bet frequency affects jackpot odds, encouraging players to continue betting without interruption.
Casino Network: Monitors the frequency of player bets and communicates this data to the jackpot server, which adjusts the odds of jackpot triggers dynamically based on the player's betting patterns.
Jackpot Server: Manages the dynamic odds calculation and updates the probability of a jackpot being triggered for players based on their bet frequency. The server tracks each player's betting activity across the casino's network of DETGs.
Players A, B, C: Players who are betting at DETGs, with their individual betting frequency directly influencing their odds of triggering the mystery jackpot.
Bet Frequency Tracker: A backend system that logs and analyzes the frequency of player bets, updating the jackpot odds based on real-time data from the DETGs.

### Implementation Details:

The system is designed to adjust the jackpot odds for individual players based on their betting patterns. The bet frequency tracker monitors each player's activity across all DETGs, logging how often they place bets in consecutive rounds or within specified time intervals. Players who maintain a consistent betting pattern—such as betting on every round without skipping—are rewarded with incrementally higher jackpot odds.

The ETGTs display real-time updates to the players, showing them how their betting activity influences their jackpot odds. For example, a player may see their jackpot odds increase by a small percentage after every 10 consecutive bets, with this data being synchronized across all terminals. If the player skips a bet or stops playing, the odds reset to a base level, incentivizing consistent participation.

The jackpot server dynamically adjusts the odds based on the player's betting frequency. The backend system calculates these odds using pre-configured algorithms, which may vary by game type or casino preferences. This flexibility allows the casino to tailor the system to different games or player demographics, making it a versatile tool for boosting player engagement.

### Example Walk-Through Scenario:

Player A is playing blackjack at a live dealer-controlled table and places bets in each of the first five consecutive rounds. The ETGT displays that Player A's jackpot odds have increased by 1%. As Player A continues to bet without skipping rounds, the system continues to increase their odds, providing real-time feedback after every additional series of bets.

Meanwhile, Player B at a nearby baccarat table also starts placing consecutive bets. After 10 rounds, Player B's ETGT shows that their jackpot odds have increased by 3%. Both players are now more engaged, aware that their consistent betting activity is directly influencing their chances of hitting the mystery jackpot.

As Player A continues to bet, they reach 20 consecutive rounds, increasing their jackpot odds by 5%. At this point, Player A is deeply invested in the game, driven by the prospect of significantly improved jackpot odds. However, if Player A were to skip a round, the system would reset their odds back to the default level, encouraging continuous play.

### Player Interaction:

Players interact with this system by placing bets during gameplay, with the ETGT providing real-time updates on their jackpot odds. As players bet more frequently, their odds of triggering a jackpot increase, offering a tangible reward for continuous engagement. This interaction encourages players to remain at the table and bet on consecutive rounds, as the system rewards them with progressively better odds.

The dynamic odds adjustment adds an extra layer of strategy to the game, where players must balance their desire to increase jackpot odds with their normal betting patterns. This feature is particularly effective at maintaining long-term engagement, as players are continuously motivated to keep betting.

### Distinguishing Innovative Concepts:

This concept distinguishes itself from traditional jackpot systems by introducing dynamic, player-centric jackpot odds based on betting frequency. Unlike conventional systems where jackpot odds are static or based solely on wager size, this system rewards consistent player engagement by progressively increasing the odds of a jackpot trigger.

The dynamic nature of this system ensures that players are constantly engaged, as they may see the immediate impact of their betting patterns on their jackpot chances. This player-centric approach differentiates the system from conventional jackpot models, offering both players and casinos a more interactive and rewarding experience.

### Distinguishing Inventive Steps:

1. Real-Time Odds Adjustment Based on Bet Frequency: The system continuously tracks the frequency of player bets and adjusts the jackpot odds in real-time, rewarding consistent betting behavior.
2. Progressive Odds Increment: The odds of triggering a jackpot increase incrementally as the player places consecutive bets, creating a clear incentive for continuous engagement.
3. Bet Frequency Reset Mechanism: If a player skips a round or stops betting for a certain period, the system resets their jackpot odds to the default level, encouraging consistent participation.

These steps distinguish this system from traditional jackpot models, which typically rely on static odds or wager size alone. The dynamic, frequency-based adjustment offers a unique and engaging player experience.

### 35 USC 101 Considerations:

This innovative concept provides a technical improvement over traditional jackpot systems by introducing a real-time, player-centric adjustment mechanism based on bet frequency. The system solves the problem of static jackpot odds by dynamically adjusting the odds based on player behavior, creating a more interactive and engaging experience.

The technical implementation of real-time bet tracking and dynamic odds calculation goes beyond abstract ideas, providing a practical solution that enhances the functionality of DETG systems. The dynamic odds adjustment mechanism represents a novel, patent-eligible advancement in gaming technology.

### Data Input:

The system collects data on player bets, tracking the frequency of each bet placed in real-time. The bet frequency tracker logs this data and communicates it to the jackpot server, which adjusts the jackpot odds accordingly. The ETGTs also display this data to players, providing real-time feedback on their current jackpot odds.

### Component Interactions and Procedural Steps:

1. Bet Frequency Tracking: The system monitors the frequency of each player's bets, logging data on consecutive bets and skipped rounds.
2. Odds Adjustment: The jackpot server dynamically adjusts the jackpot odds based on the player's bet frequency, providing real-time updates through the ETGT.
3. Real-Time Feedback: Players receive real-time feedback on their current jackpot odds through the ETGT, encouraging continuous betting.

### Data Processing:

The system processes data on player bets in real-time, using algorithms to calculate the progressive adjustment of jackpot odds based on bet frequency. The jackpot server continuously updates the odds based on this data, ensuring that players see the immediate impact of their betting activity.

### Outputs and Responses:

The primary output is the real-time update provided to players on their current jackpot odds, displayed on the ETGT. The system also adjusts the odds dynamically, providing a responsive and engaging gameplay experience.

### Data Storage and Reporting:

The system stores data on player betting patterns, jackpot odds, and adjustments made. This data is used for audit and reporting purposes, allowing the casino to track player engagement and jackpot outcomes.

### Error Handling and Security Measures:

Error handling mechanisms ensure that player bets are accurately tracked and that jackpot odds are correctly adjusted. Security measures protect the integrity of the system, preventing manipulation of bet frequency data or jackpot odds.

### End of Interaction:

Once a player triggers the jackpot or stops betting, the system resets their odds, and the process begins anew for the next session. Players are notified of the final outcome, and the system resets the jackpot conditions for the next round.

### Innovative Concept 68—Socially Triggered Group Jackpots Across Multiple DETGs

### Identification of Concept:

This innovative concept introduces the notion of group-based jackpots in Dealer-controlled Electronic Table Games (DETGs), where social interactions between players may trigger jackpot events. Specifically, the system monitors how players across multiple DETGs interact within the same network and rewards group dynamics such as simultaneous high bets, coordinated betting actions, or shared game outcomes. For example, if a group of players places bets of a certain size at the same time across different tables, the system may trigger a group jackpot, rewarding all participating players.

The concept is aimed at fostering collaboration among players across different tables, encouraging coordinated play, and increasing engagement by making social interaction a specific component of jackpot eligibility.

### Sequence Diagram Components:

Electronic Table Game Terminals (ETGTs): Display real-time information about group-based jackpot conditions, notifying players of potential jackpots that may be triggered by social gameplay. The ETGTs also communicate the results of other players' actions in real-time, encouraging players to coordinate.
Casino Network: Monitors social interactions across all connected DETGs, tracking events like simultaneous high bets, coordinated actions, and shared outcomes. The network determines when the conditions for a group jackpot are met and communicates this to the jackpot server.
Jackpot Server: Manages the group jackpot pool, triggering the reward when the social interaction conditions are met. It also calculates the distribution of the jackpot among all eligible players.
Players A, B, C: Players across different DETGs who engage in social actions such as coordinated betting, leading to the activation of the group jackpot.
Interaction Tracker: A backend system component that monitors social gameplay events and determines when a group of players qualifies for a socially triggered jackpot.

### Implementation Details:

The group jackpot system is integrated across multiple DETGs, with each terminal connected to a central casino network that monitors player actions. The system tracks various social gameplay conditions, such as players placing large bets simultaneously or achieving synchronized game outcomes (e.g., winning hands in baccarat or blackjack at the same time). When these conditions are met, the interaction tracker sends a signal to the jackpot server, triggering the group jackpot.

Players are informed of the potential for group jackpots through real-time notifications on their ETGTs, which also display the necessary conditions for triggering the jackpot. The jackpot server dynamically adjusts the jackpot pool based on the number of players involved and the magnitude of the social interaction. For instance, if three players from different tables place identical bets at the same moment, they may trigger a group jackpot that rewards each player equally or based on their respective contributions.

### Example Walk-Through Scenario:

Player A is playing blackjack at one DETG, while Players B and C are engaged in baccarat and roulette at different tables. During their respective games, the system detects that all three players place high-value bets within the same 10-second window. This synchronized action meets the condition for triggering a group jackpot.

Immediately, all three players receive notifications on their ETGTs that the group jackpot has been activated. The jackpot server calculates the total prize based on the size of their bets and distributes the winnings evenly across the three players. The group jackpot adds an unexpected element of excitement to their gameplay, rewarding them for their synchronized actions, even though they are playing different games at separate DETGs.

### Player Interaction:

Players interact with the system through coordinated gameplay across different DETGs. The real-time nature of the system encourages players to engage in social actions, such as placing simultaneous bets or trying to achieve synchronized outcomes in different games. Players are notified when their actions contribute to the group jackpot, creating a sense of teamwork and social engagement.

This interaction is unique because it transcends individual gameplay, allowing players to collaborate with others at different tables to achieve a shared goal. The potential for a group jackpot adds an extra layer of excitement and motivation for players to interact with the system and with each other.

### Distinguishing Innovative Concepts:

This innovative concept distinguishes itself by introducing a social dynamic to jackpot triggers, creating a collaborative gaming experience that spans multiple DETGs. Unlike traditional jackpot systems that focus solely on individual player actions, this system rewards coordinated group behavior, encouraging players to engage with each other in new ways.

The concept of a socially triggered group jackpot is novel in that it transforms otherwise independent gameplay into a shared experience, where players may collectively work toward triggering a jackpot. This social element makes the gaming experience more interactive and immersive, providing players with a sense of community and collaboration.

### Distinguishing Inventive Steps:

1. Simultaneous Betting as a Trigger: The system tracks when multiple players place simultaneous bets across different DETGs, using this as a condition to trigger a group jackpot.
2. Social Interaction Monitoring: The system continuously monitors social gameplay dynamics, such as coordinated betting or shared outcomes, to determine when group jackpots are activated.
3. Dynamic Jackpot Distribution: The jackpot server adjusts the payout based on the size of the bets and the number of players involved in the group interaction, ensuring that the jackpot reflects the social engagement of the players.

These steps differentiate the system from conventional jackpot models by introducing a social element that rewards group behavior, transforming the gaming experience into a collaborative effort.

### 35 USC 101 Considerations:

This innovative concept provides a concrete improvement over traditional jackpot systems by introducing a socially driven mechanism for triggering jackpots. The system solves the problem of isolated gameplay by encouraging social interaction and collaboration across multiple DETGs, creating a more engaging and dynamic experience for players.

The technical implementation of social interaction tracking and dynamic jackpot distribution goes beyond abstract ideas, providing a practical solution that enhances the functionality of DETG systems. The socially triggered group jackpot represents a novel and patent-eligible advancement in gaming technology.

### Data Input:

The system collects data on player actions, including bet sizes, timing, and game outcomes. It monitors the interactions between players across different DETGs to determine when the conditions for a group jackpot are met. The data is processed in real-time to ensure that all relevant social actions are tracked accurately.

### Component Interactions and Procedural Steps:

1. Interaction Tracking: The system monitors the actions of players across different DETGs, looking for coordinated behavior that meets the conditions for a group jackpot.
2. Group Jackpot Activation: When the conditions are met, the interaction tracker signals the jackpot server, which triggers the jackpot and calculates the prize distribution.
3. Player Notification: The ETGTs notify players in real-time when a group jackpot is triggered, displaying the winnings and encouraging continued social interaction.

### Data Processing:

The system processes data on player interactions in real-time, tracking social actions such as simultaneous betting or shared game outcomes. The jackpot server dynamically adjusts the jackpot pool based on the number of players involved and the magnitude of their social engagement.

### Outputs and Responses:

The primary output is the real-time notification provided to players when a group jackpot is triggered, informing them of their winnings and encouraging further social interaction. The system also dynamically adjusts the jackpot pool based on the players' coordinated actions.

### Data Storage and Reporting:

The system stores data on player interactions, jackpot triggers, and payouts. This data is used for audit and reporting purposes, allowing the casino to track player behavior and optimize the socially triggered jackpot system for future use.

### Error Handling and Security Measures:

Error handling ensures that social interactions are accurately tracked and that the group jackpot is triggered based on valid player actions. Security measures protect the integrity of the system, preventing manipulation of social gameplay data.

### End of Interaction:

Once a group jackpot is triggered and the winnings are distributed, the system resets the conditions for the next group interaction. Players are encouraged to continue engaging with each other to trigger additional group jackpots in future game rounds.

### Innovative Concept 69—Dealer-Controlled Incremental Jackpot Boost Based on Table Events

### Identification of Concept:

This innovative concept introduces a dealer-controlled feature that dynamically boosts jackpot values based on certain table events during live gameplay. For example, the dealer may trigger incremental increases to the jackpot pool when specific events occur, such as a player hitting a natural blackjack or rolling a specific number on a dice in a craps game. The dealer has the ability to manually add these boosts, or the system may automate the process based on predefined game conditions. This system enhances the player experience by tying the jackpot potential directly to notable game events, creating more engagement during notable moments of gameplay.

The feature is integrated into Dealer-controlled Electronic Table Games (DETGs) and designed to encourage player excitement through dealer participation. Additionally, the jackpot boosts are applied dynamically, meaning the dealer or the system may respond to in-game milestones in real-time, ensuring the jackpot pool grows more rapidly as events unfold.

### Sequence Diagram Components:

Electronic Table Game Terminals (ETGTs): Display real-time information on current jackpot amounts and indicate when a jackpot boost has been triggered by the dealer or system. Players may track how these incremental boosts affect the overall jackpot.
Casino Network: Tracks player actions and specific game events, relaying this data to the jackpot server to determine when to apply incremental jackpot boosts.
Jackpot Server: Manages the jackpot pool and applies incremental increases based on the game events. The server ensures that all DETGs connected to the system are updated in real-time with the boosted jackpot amounts.
Dealer: May manually trigger incremental jackpot boosts during certain table events, enhancing player engagement. The dealer interacts with the system either through direct inputs or automatically based on predefined conditions.
Players A, B, C (at various ETGTs): Players whose actions may trigger events that lead to incremental jackpot boosts. These players benefit from the boosted jackpots when they occur during gameplay.

### Implementation Details:

The dealer-controlled incremental jackpot system is integrated with the DETGs, enabling real-time boosts to the jackpot based on specific game events. Each DETG is connected to the casino network, which tracks player actions and game conditions. When a predefined event occurs—such as a player achieving a high-value hand in blackjack or a rare dice roll in craps—the system either automatically triggers a jackpot boost or allows the dealer to manually input the boost through a dealer interface.

The jackpot server dynamically adjusts the jackpot pool, adding the boost based on the event's significance. Smaller events, such as a blackjack win, may result in a modest increase, while more significant events like a royal flush in poker may lead to a larger jackpot boost. The ETGTs notify players in real-time about the boosted jackpot amounts, keeping them informed of how the jackpot pool is evolving during gameplay.

In addition to automatic boosts, the dealer has the flexibility to manually apply boosts during moments of excitement to maintain player engagement. This interaction fosters a more dynamic and responsive gaming environment, where both players and dealers may influence the outcome of the jackpot.

### Example Walk-Through Scenario:

Player A is seated at a blackjack table and wins a natural blackjack. The system automatically detects this event and triggers a modest jackpot boost, adding 5% to the current pool. The ETGT immediately notifies Player A and the other participants that the jackpot has increased.

Meanwhile, Player B, playing at a nearby poker table, hits a royal flush. The dealer at this table, recognizing the significance of the hand, manually triggers a jackpot boost through their dealer interface, adding 10% to the jackpot pool. All connected ETGTs are updated in real-time, displaying the new jackpot total.

Player C, observing the rapid increase in the jackpot pool due to these events, is encouraged to place a higher wager, hoping to trigger the jackpot before it grows any further. The excitement builds as the jackpot pool continues to grow dynamically based on player actions and dealer decisions.

### Player Interaction:

Players interact with the system through normal gameplay at the ETGTs. As they play, their actions may trigger specific table events that result in incremental jackpot boosts. These boosts are communicated in real-time, keeping players informed of how their actions are affecting the jackpot pool. Players are motivated to continue playing as the jackpot grows, knowing that certain actions, whether performed by themselves or others, may increase the potential jackpot prize.

The dynamic nature of the system, which ties in-game events to jackpot growth, enhances player engagement by making them feel more directly involved in the outcome of the jackpot.

### Distinguishing Innovative Concepts:

This concept introduces a unique system that allows for dealer-controlled incremental jackpot boosts based on specific table events, creating a more interactive and dynamic jackpot experience. Unlike conventional systems that rely on random or bet-based contributions, this system directly ties notable gameplay events to jackpot growth, giving players and dealers a more active role in the jackpot process.

The ability for dealers to manually apply jackpot boosts adds an additional layer of excitement, as players may anticipate jackpot increases during notable moments in the game. This dealer-driven interaction distinguishes the system from other automated jackpot mechanisms, creating a more personalized and responsive gaming experience.

### Distinguishing Inventive Steps:

1. Event-Based Jackpot Boosts: The system ties specific game events, such as player achievements, to incremental jackpot boosts, ensuring that the jackpot pool grows dynamically in response to in-game milestones.
2. Dealer-Controlled Boosts: The dealer has the ability to manually apply jackpot boosts during exciting moments, providing a more interactive experience and increasing player engagement.
3. Real-Time Jackpot Updates: The system updates the jackpot pool in real-time, notifying all players across the connected DETGs of the current jackpot value, ensuring that everyone is aware of how their gameplay affects the jackpot.

These steps distinguish this system from traditional jackpot models by introducing dynamic, event-based contributions and providing the dealer with direct control over jackpot boosts.

### 35 USC 101 Considerations:

This innovative concept provides a concrete improvement over traditional jackpot systems by incorporating dealer-controlled, event-based jackpot boosts. The system solves the problem of static, random jackpot contributions by creating a more dynamic and interactive jackpot process tied to in-game milestones.

The technical implementation integrates real-time event tracking and dynamic jackpot adjustments, providing a practical application that enhances the functionality of DETG systems. The ability to tie specific gameplay events to jackpot boosts represents a novel and patent-eligible advancement in casino gaming technology.

### Data Input:

The system collects data on player actions and specific table events, such as achieving a natural blackjack or rolling a certain number in craps. This data is used to trigger incremental jackpot boosts, either automatically or through dealer input.

### Component Interactions and Procedural Steps:

1. Event Detection: The system monitors player actions and game conditions, identifying when predefined events occur that qualify for a jackpot boost.
2. Jackpot Adjustment: The jackpot server applies an incremental boost to the jackpot pool, updating the total in real-time based on the significance of the event.
3. Dealer Input: The dealer may manually apply a jackpot boost during notable moments of gameplay, adding to the overall jackpot pool and increasing player excitement.

### Data Processing:

The system processes data on player actions and game conditions, dynamically adjusting the jackpot pool based on the occurrence of predefined events. The jackpot server continuously updates the total in real-time, providing instant feedback to players and dealers.

### Outputs and Responses:

The system outputs real-time updates on the current jackpot value, notifying all connected ETGTs of any incremental boosts applied during gameplay. Players receive feedback on how their actions or dealer inputs are affecting the jackpot pool, enhancing their overall gaming experience.

### Data Storage and Reporting:

The system stores data on player actions, event triggers, and jackpot boosts for audit and reporting purposes. This data is used to track player engagement and monitor the effectiveness of the event-based jackpot system.

### Error Handling and Security Measures:

Error handling ensures that event triggers and jackpot boosts are applied correctly and that the jackpot pool is accurately updated. Security measures protect the integrity of the system, preventing unauthorized manipulation of jackpot values or dealer inputs.

### End of Interaction:

Once a jackpot is triggered or a session ends, the system resets the jackpot pool and prepares for the next round of contributions. Players are notified of the final jackpot value and outcome, and the dealer may initiate the next game round.

### Innovative Concept 70—Personalized Jackpot Modifiers Based on Player Loyalty Status

### Identification of Concept:

This innovative concept introduces a system where players receive personalized jackpot modifiers based on their loyalty status within the casino's rewards program. By integrating loyalty systems with the jackpot mechanism in Dealer-controlled Electronic Table Games (DETGs), players may earn increased chances of winning jackpots or access exclusive jackpot tiers based on their accumulated points or tier level. This system encourages player loyalty by offering enhanced benefits tied to the player's existing loyalty status, such as platinum or gold membership levels, which may correspond to higher jackpot multipliers or reduced jackpot thresholds.

The system dynamically adjusts each player's jackpot odds or offers special jackpot conditions, such as doubling their chances of triggering a jackpot, based on the player's loyalty tier. This integration adds a personalized and incentivizing element to the gameplay, motivating players to engage with both the games and the casino's loyalty program.

### Sequence Diagram Components:

Electronic Table Game Terminals (ETGTs): Display personalized jackpot modifiers based on the player's loyalty status. These terminals inform players of their enhanced jackpot opportunities tied to their loyalty tier.
Casino Network: Tracks player loyalty status and synchronizes this data with the jackpot system. It ensures that each player's rewards status is reflected in their jackpot odds or tier access.
Loyalty Server: Manages the player's loyalty points and tier status, continuously updating the player's standing based on their activity. It communicates with the jackpot server to adjust jackpot modifiers accordingly.
Jackpot Server: Dynamically adjusts the odds or thresholds for jackpot triggers based on the player's loyalty tier, providing real-time updates to the player.
Players A, B, C: Represent players participating in DETGs, each with different loyalty statuses. Players with higher statuses receive personalized jackpot benefits.
Loyalty Tracker: A backend system component that tracks player activity, calculates loyalty points, and updates the player's tier status in real time.

### Implementation Details:

This concept integrates loyalty tracking with the DETG jackpot system, allowing players to receive enhanced jackpot benefits based on their tier within the casino's loyalty program. As players accumulate points from gaming activity or other casino-related spending, their loyalty tier increases. The loyalty server continuously monitors this data and communicates it to the jackpot server.

When a player reaches a new tier level, such as gold or platinum, the ETGT updates to display personalized jackpot modifiers, such as increased odds of hitting the jackpot or exclusive access to certain jackpot tiers. The jackpot server dynamically adjusts the thresholds or odds based on the player's status, ensuring that high-status players have better jackpot opportunities.

For example, a gold-tier player may have a 1.5× multiplier applied to their chances of triggering the jackpot, while a platinum-tier player may have a 2× multiplier. The system continuously monitors the player's status, ensuring real-time updates to their jackpot odds and providing a seamless, personalized gaming experience.

### Example Walk-Through Scenario:

Player A, who holds a gold-tier status in the casino's loyalty program, begins a session at a DETG. Upon logging in, the ETGT displays a notification indicating that Player A's jackpot odds have been enhanced by 1.5× due to their loyalty tier. Meanwhile, Player B, a platinum-tier player, receives a notification that their odds have been doubled.

As Player A places wagers, the jackpot server continuously applies the 1.5× modifier to their jackpot chances. After a few rounds, Player A triggers the mystery jackpot, receiving a payout that is enhanced by their loyalty status. On the other hand, Player B, who has a higher-tier status, has access to an exclusive jackpot tier, which offers even larger potential rewards.

Throughout the session, both players are reminded of their personalized jackpot modifiers, encouraging continued gameplay and fostering loyalty to the casino.

### Player Interaction:

Players interact with the system by simply engaging in regular gameplay while logged into their loyalty account. The ETGT displays real-time information about their loyalty-based jackpot modifiers, keeping players informed of their enhanced odds or exclusive jackpot tiers. This interaction remains passive and seamless, with the system automatically applying the appropriate modifiers based on the player's loyalty status.

Players are motivated to continue playing, knowing that their loyalty status directly influences their jackpot potential. This integration also incentivizes players to engage more with the casino's loyalty program, as higher tiers offer better jackpot benefits.

### Distinguishing Innovative Concepts:

This concept differentiates itself by integrating loyalty programs with the jackpot system, creating personalized jackpot opportunities based on the player's tier status. Traditional jackpot systems are typically uniform for all players, but this system tailors the jackpot experience to each player, offering enhanced odds or access to exclusive jackpots based on loyalty.

The use of real-time loyalty tracking to adjust jackpot modifiers adds a new dimension to the gaming experience, making it more personalized and rewarding for loyal players. This concept also encourages long-term engagement, as players are motivated to reach higher loyalty tiers to unlock better jackpot opportunities.

### Distinguishing Inventive Steps:

1. Loyalty-Based Jackpot Modifier Application: The system dynamically adjusts jackpot odds based on the player's loyalty status, providing personalized benefits to high-tier players.
2. Real-Time Tier Tracking and Notification: The ETGT continuously tracks and displays real-time updates on the player's loyalty tier and how it affects their jackpot potential.
3. Exclusive Jackpot Access: Higher-tier players gain access to exclusive jackpot tiers with larger rewards, creating a personalized and incentivized gaming experience.

These steps differentiate this system from traditional jackpot models by offering a tailored experience that rewards player loyalty.

### 35 USC 101 Considerations:

This innovative concept offers a concrete improvement over traditional jackpot systems by integrating loyalty-based modifiers into the jackpot process. It addresses the problem of static jackpot odds by introducing dynamic, personalized modifiers that reward player loyalty, creating a more engaging and interactive experience.

The technical solution of integrating loyalty tracking with real-time jackpot adjustments goes beyond abstract ideas, providing a practical improvement in casino gaming functionality. The personalized jackpot modifiers represent a novel, patent-eligible advancement in gaming technology.

### Data Input:

The system collects data on player loyalty status, including points earned, tier level, and gaming activity. This data is used to calculate the player's personalized jackpot odds and determine their eligibility for exclusive jackpot tiers.

### Component Interactions and Procedural Steps:

1. Loyalty Status Tracking: The system tracks the player's loyalty points and tier status, updating the ETGT with real-time notifications.
2. Jackpot Modifier Application: The jackpot server adjusts the player's odds or access to exclusive jackpots based on their loyalty status.
3. Player Notification: The ETGT provides real-time feedback to the player, displaying their current jackpot modifiers and any available exclusive jackpots.

### Data Processing:

The system processes data from the loyalty server to determine each player's tier status and adjusts the jackpot odds accordingly. The jackpot server continuously updates the odds in real-time, ensuring that players with higher loyalty statuses receive enhanced jackpot opportunities.

### Outputs and Responses:

The primary output is the personalized jackpot modifiers displayed on the ETGT, which update in real-time based on the player's loyalty status. The system also dynamically adjusts jackpot odds and triggers exclusive jackpot tiers for high-status players.

### Data Storage and Reporting:

The system stores data on player loyalty status, jackpot triggers, and payouts. This data is used for reporting purposes and to track player engagement with the loyalty program and jackpot system.

### Error Handling and Security Measures:

Error handling ensures that loyalty status is accurately tracked and that personalized jackpot modifiers are correctly applied. Security measures protect the integrity of the loyalty program and prevent manipulation of tier-based jackpot odds.

### End of Interaction:

Once a player logs out or triggers a jackpot, the system resets the player's loyalty-based modifiers and prepares for the next session. Players are notified of any changes to their loyalty status, and the process continues

### Innovative Concept 71—Enhanced Jackpot Odds for Players Participating in Multiple Concurrent DETG Sessions

### Identification of Concept:

This innovative concept introduces the idea of providing enhanced jackpot odds to players who simultaneously participate in multiple games across different Dealer-controlled Electronic Table Games (DETGs). By participating in concurrent sessions at various tables, players are rewarded with increased chances of hitting a mystery jackpot. The system tracks each player's engagement across different tables, adjusting their jackpot odds dynamically based on the number of concurrent sessions they are involved in. This incentivizes players to engage with multiple games simultaneously, boosting their engagement and increasing the casino's revenue.

The system may be implemented by tracking the activity of each player through the casino's network of DETGs, adjusting the jackpot odds in real-time based on their participation in multiple concurrent sessions. This adds an extra layer of strategy, where players may optimize their chances of winning by engaging with several games simultaneously, fostering higher player retention.

### Sequence Diagram Components:

Electronic Table Game Terminals (ETGTs): Track player participation in concurrent games and display their enhanced jackpot odds based on real-time data from other tables they are participating in.
Casino Network: Monitors and logs player activity across all connected DETGs, ensuring that the system may adjust the jackpot odds dynamically as players join or leave different sessions.
Jackpot Server: Manages the jackpot pool, adjusting the odds of winning based on the number of concurrent sessions each player is engaged in. The server ensures that players participating in multiple sessions have proportionally higher jackpot odds.
Players A, B, C: Players who are engaged in multiple concurrent game sessions, receiving enhanced jackpot odds based on their participation across various DETGs.
Session Tracker: A backend system that monitors all player sessions and adjusts jackpot odds based on the number of concurrent games being played.

### Implementation Details:

The system dynamically adjusts each player's jackpot odds based on the number of concurrent DETG sessions they are participating in. For example, a player who participates in two games simultaneously may have their jackpot odds doubled, while a player in three concurrent games may see their odds tripled. The ETGTs display these enhanced odds in real-time, giving players feedback on how their concurrent play is affecting their chances of hitting the jackpot.

The casino network tracks player activity across all connected DETGs, feeding this data into the session tracker, which monitors how many games each player is involved in at any given time. This data is then relayed to the jackpot server, which adjusts the jackpot odds dynamically.

For players, the enhanced odds serve as an incentive to participate in more games at once, increasing engagement and potentially boosting the overall jackpot pool as more wagers are placed across the network. The system encourages players to explore different game types, as the enhanced jackpot odds apply regardless of the specific game being played.

### Example Walk-Through Scenario:

Player A begins by participating in a live dealer blackjack game at one DETG. After a few rounds, they decide to join a baccarat table while still playing blackjack. The system detects that Player A is now engaged in two concurrent sessions and increases their jackpot odds accordingly. The ETGT at both tables displays Player A's new, enhanced odds of triggering the jackpot.

Meanwhile, Player B is playing roulette and decides to join a second roulette table at another DETG. The system adjusts their jackpot odds as well, ensuring that Player B's chances of hitting the jackpot are significantly higher than if they were playing only one game.

Player A and Player B are both motivated to continue playing across multiple games, knowing that their participation in concurrent sessions increases their chances of winning a jackpot. This creates an engaging experience where players feel rewarded for playing multiple games simultaneously.

### Player Interaction:

Players interact with the system by simply participating in multiple game sessions. The ETGTs display real-time updates on how their concurrent gameplay is affecting their jackpot odds. Players are notified when they receive enhanced odds, encouraging them to continue playing multiple games at once to maximize their chances of winning the jackpot.

This system adds a strategic element to the gameplay, where players must balance their attention between multiple games to take full advantage of the enhanced jackpot odds. The interaction is seamless, with the system handling all the calculations and updates in the background, allowing players to focus on their games.

### Distinguishing Innovative Concepts:

This concept introduces the novel idea of enhancing jackpot odds based on concurrent gameplay across multiple DETGs. Unlike traditional jackpot systems that only consider wager size or random triggers, this system rewards players for engaging with multiple games at once. By doing so, the system increases player engagement and fosters long-term loyalty, as players are incentivized to participate in more games to improve their chances of winning.

The system's ability to dynamically adjust odds based on real-time player activity across multiple sessions is a notable differentiator, providing a unique and engaging experience for players and adding value to the casino by increasing overall game participation.

### Distinguishing Inventive Steps:

1. Concurrent Session Tracking: The system monitors player participation in multiple DETG sessions simultaneously, ensuring that jackpot odds are adjusted in real-time based on the number of concurrent games.
2. Dynamic Jackpot Odds Adjustment: The jackpot server dynamically adjusts the odds of triggering the jackpot based on the number of games each player is engaged in, increasing their chances proportionally as they participate in more sessions.
3. Real-Time Feedback to Players: The ETGTs provide players with real-time updates on how their concurrent gameplay is affecting their jackpot odds, creating an engaging and transparent system that encourages continuous play.

These steps distinguish this system from conventional jackpot models by introducing a dynamic, engagement-based approach to jackpot determination.

### 35 USC 101 Considerations:

This innovative concept provides a concrete improvement over traditional jackpot systems by integrating concurrent gameplay as a determining factor for jackpot odds. The system solves the problem of static jackpot triggers by rewarding players for engaging with multiple DETGs simultaneously, creating a more interactive and engaging experience.

This technical solution integrates real-time session tracking and dynamic jackpot odds adjustment into DETG systems, providing a tangible improvement in casino gaming functionality. The use of concurrent session-based jackpot enhancements represents a novel and patent-eligible advancement in gaming technology.

### Data Input:

The system collects data on player participation across multiple DETGs, tracking how many concurrent sessions each player is engaged in. The session tracker monitors this data in real-time, feeding it into the jackpot server to adjust the jackpot odds accordingly.

### Component Interactions and Procedural Steps:

1. Session Monitoring: The system tracks player participation across multiple DETGs, updating the session tracker with real-time data on how many games each player is involved in.
2. Jackpot Odds Adjustment: The jackpot server dynamically adjusts the odds based on the number of concurrent sessions, ensuring that players who engage with more games have higher jackpot potential.
3. Real-Time Feedback: The ETGTs provide real-time feedback to players, notifying them of their enhanced jackpot odds based on their concurrent gameplay.

### Data Processing:

The system processes data on player sessions and dynamically adjusts the jackpot odds in real-time. The session tracker continuously updates the data, ensuring that the jackpot server reflects the most accurate information on each player's participation.

### Outputs and Responses:

The primary output is the real-time adjustment of jackpot odds, which is communicated to players through their ETGTs. The system also updates the jackpot pool and potential payout based on player participation across multiple DETGs.

### Data Storage and Reporting:

The system stores data on player participation, session duration, and jackpot odds adjustments. This data is used for audit and reporting purposes, providing insights into player engagement and system performance.

### Error Handling and Security Measures:

Error handling mechanisms ensure that player participation is accurately tracked and that jackpot odds are correctly adjusted based on the number of concurrent sessions. Security measures protect the integrity of the system, preventing unauthorized manipulation of session data or jackpot odds.

### End of Interaction:

Once a player finishes their concurrent sessions, the system resets their jackpot odds and returns to normal gameplay conditions. Players are notified of their final jackpot odds, and the system prepares for the next round of participation.

Innovative Concept 72—Player-Eligibility based On Activity

Identification of Concept: This innovative concept involves setting player eligibility for jackpots based on specific activity-related criteria. Players may become eligible for a jackpot after reaching defined thresholds, such as contributing a certain number of side bets or achieving a VIP level within the casino's player tracking system. This incentivizes prolonged gameplay, loyalty, and higher wager participation. The feature may be integrated into Live dealer-controlled multiplayer games and DETGs by utilizing a combination of hardware sensors, player tracking systems, and game management software to monitor player activities and update eligibility in real-time. The system may ensure that only players who meet these criteria participate in jackpot rounds, adding a layer of exclusivity and encouraging increased engagement.

### Sequence Diagram Components

1. Electronic Table Game Terminal (ETGT): Captures player actions, such as wagers and participation in side bets.
2. Player A & Player B: Represent different players contributing to the game, whose activities are monitored for eligibility tracking.
3. Player Tracking System (PTS): Records each player's activity, including number of side bets placed or VIP level achievements.
4. Casino Network Servers: Handle real-time data exchange between the DETG system and the central gaming network.
5. Jackpot Manager System: Processes jackpot eligibility criteria, checks if players meet the defined thresholds, and updates their status.
6. Random Number Generator (RNG): Ensures the fairness of jackpot distribution by triggering based on game events or random intervals.
7. Player Game Meters: Record individual player's wagering activity for calculating eligibility.
8. Backend System: Handles data aggregation, communication with central servers, and calculation of jackpot contributions.

Implementation Details: In a DETG system, player eligibility for the mystery jackpot may be based on cumulative activities such as placing side bets or reaching a VIP threshold. Each ETGT may be equipped with software that tracks the player's actions, relaying the data to the casino's Player Tracking System (PTS). This system communicates with casino servers to determine when a player has met the required conditions. For instance, each player's contributions to side bets or the number of rounds they've participated in may be calculated and tracked. Once a threshold is reached, the system updates their eligibility for jackpot participation.

The DETG may present dynamic notifications to the player on the terminal's screen, informing them when they've become eligible for the jackpot. Meanwhile, the Jackpot Manager System verifies eligibility before allowing participation in the mystery jackpot. This may involve cross-referencing data from the casino's loyalty program to ensure VIP status, further enhancing the personalized gaming experience. Implementation also includes security measures to prevent fraud, ensuring only qualified players are included in the jackpot pool.

Example Walk-through Scenario: Imagine Player A has been playing a DETG blackjack game and has consistently placed side bets for the past 10 rounds. The system tracks each side bet through sensors and relays the data to the casino's Player Tracking System. As Player A reaches the threshold (e.g., 10 side bets), their ETGT displays a message: “Congratulations! You are now eligible for the mystery jackpot.” Player B, who has not placed as many side bets, remains ineligible and is not shown this message.

Meanwhile, the Jackpot Manager periodically checks for eligible players. At the end of each round, a system prompt informs Player A that they are included in the jackpot pool, while Player B remains uninformed. When the jackpot is triggered, Player A's eligibility status is validated before the jackpot win is distributed.

Player Interaction: Multiple players interact with their individual terminals, each attempting to qualify for the jackpot. The DETG tracks their wagers, notifying them when they reach eligibility thresholds. For example, Player A may decide to place a higher number of side bets after being notified that they are close to qualifying for the jackpot. This real-time feedback loop enhances player engagement, as they are encouraged to continue placing side bets or aim for higher VIP levels to increase their jackpot odds.

Distinguishing Innovative Concepts: This concept introduces dynamic player eligibility based on specific criteria such as side bet activity or VIP status. In conventional systems, eligibility for jackpots is typically uniform across all players regardless of their activity. By contrast, this system differentiates players based on their participation and loyalty. This level of customization, enabled by integrating Player Tracking Systems (PTS) with the Jackpot Manager, creates a personalized gaming experience that incentivizes more sustained engagement.

Additionally, this concept leverages the casino's loyalty program data, providing added benefits to VIP players, which further differentiates it from typical ETG and EGM systems where all players generally have equal odds of jackpot participation.

### Distinguishing Inventive Steps

1. Eligibility Tracking through Activity Monitoring: The DETG tracks player activities, including side bets and VIP levels, and determines jackpot eligibility based on these metrics.
2. Real-Time Notifications of Eligibility: The system provides players with immediate feedback when they qualify for jackpot participation, driving engagement.
3. Dynamic Jackpot Participation: Only players who meet specific activity thresholds are included in the jackpot pool, unlike traditional ETGs where eligibility is uniformly distributed.

These steps uniquely differentiate this concept by adding layers of eligibility criteria, providing a competitive advantage in engaging players who are motivated to meet specific thresholds to qualify.

35 USC 101 Considerations: This innovative concept extends beyond an abstract idea by integrating real-time tracking of player activity with a robust eligibility system, creating a technical improvement in managing jackpot systems for DETGs. The concept solves the problem of static jackpot participation by introducing dynamic, activity-based criteria, which is a novel implementation in casino gaming systems.

The system integrates player data, such as side bet participation and VIP status, into a practical application that improves the engagement and retention of players. This technological improvement enhances both the casino's ability to drive loyalty and the players' experience, creating a more competitive and rewarding environment. The use of real-time data collection and eligibility validation presents a clear advancement over prior static systems.

Data Input: Players input data through their wagers and game actions, such as placing side bets or using their VIP status, which are tracked by the DETG. Additionally, the system gathers input from the Player Tracking System (PTS) regarding the players' eligibility for jackpots. This data is transmitted to the casino's central servers, ensuring accurate tracking of player contributions.

### Component Interactions and Procedural Steps

1. Players place wagers on their terminals (ETGTs), including side bets.
2. ETGT tracks these bets and updates player game meters.
3. PTS communicates the player's actions to the casino servers to monitor activity levels.
4. Once the threshold is met, the Jackpot Manager System updates the player's eligibility.
5. The system verifies eligibility before triggering a jackpot win.
6. Data is exchanged between ETGT, Jackpot Manager, and casino servers in real-time to ensure accurate jackpot processing.

Data Processing: The system processes player inputs, calculating whether they meet the jackpot eligibility criteria. It also performs real-time tracking of side bet contributions and VIP status, ensuring only qualified players participate. These calculations take place in the casino network's backend, ensuring accuracy and compliance with game rules.

Outputs and Responses: Once a player qualifies for the jackpot, the system generates an immediate notification on the terminal screen, informing the player of their eligibility. At the time of jackpot trigger, the system verifies the player's participation and awards the jackpot if all criteria are met.

Data Storage and Reporting: Data related to side bets, VIP levels, and eligibility status are stored in the casino's central database, where it may be accessed for reporting purposes. This data includes player activity logs, wager amounts, and jackpot contributions.

Error Handling and Security Measures: The system ensures that only players who meet the eligibility criteria may participate in the jackpot, using validation checks to prevent unauthorized participation. It also uses encryption to protect player data during transmission between ETGTs and casino servers.

End of Interaction: After the jackpot is awarded, the system resets the player eligibility status for the next round. All players must meet the criteria again to qualify for subsequent jackpots. The system also clears any temporary data related to the previous round's jackpot calculations.

### Innovative Concept 73—Random Bonus Jackpot Activation

Identification of Concept: This innovative concept introduces a mystery bonus jackpot triggered randomly during gameplay, independent of game outcomes or wager amounts. Unlike traditional jackpots tied to specific game results or side bets, this jackpot may be activated at any point during a live dealer-controlled multiplayer game. The randomness of the bonus creates an additional layer of excitement for players, as they are incentivized to continue playing, knowing that the jackpot may be awarded at any time. The concept may be implemented in Live Dealer Electronic Game Table Systems (DETGs) by integrating a random event generator within the system's software architecture to trigger the jackpot at unpredictable intervals.

### Sequence Diagram Components

1. Electronic Table Game Terminal (ETGT): Captures player activity and displays real-time notifications when the random bonus jackpot is triggered.
2. Player A & Player B: Multiple players participating in the game and eligible for the randomly triggered bonus.
3. Random Event Generator: Software module that determines when the random bonus jackpot is triggered.
4. Casino Gaming Network Server: Coordinates communication between DETG terminals, manages the random jackpot triggering mechanism, and processes payouts.
5. Player Tracking System (PTS): Monitors player participation, ensuring that all active players are considered eligible for the bonus.
6. Jackpot Display System: Displays the current value of the bonus jackpot and alerts players when it has been triggered.
7. Game Server: Runs the specific gameplay logic and communicates with the Random Event Generator to initiate the jackpot trigger.

Implementation Details: To implement this concept, each ETGT may be configured to interact with a Random Event Generator that is part of the DETG's specific software. The generator runs independently of game logic and tracks time-based intervals or random thresholds to decide when to trigger the bonus jackpot. When a triggering condition is met, the Casino Network Server communicates with all connected ETGTs, informing them that the random bonus has been activated. This ensures that any eligible player seated at the table may win the jackpot, regardless of whether their current hand is a winning or losing one.

The system uses a RNG to ensure the randomness of the jackpot trigger and fairness in player selection. Implementation may also involve the Player Tracking System (PTS), ensuring that players who have contributed a minimum number of wagers or have been active for a certain period are included in the eligible pool.

Example Walk-through Scenario: Consider Player A and Player B, both seated at a DETG system playing baccarat. Player A has been playing for 20 minutes, and Player B has just joined the game. Unbeknownst to either player, the Random Event Generator reaches a trigger point, activating the random bonus jackpot. The game's display notifies both players that the bonus has been triggered, creating excitement across the table.

As the game progresses, the system randomly selects Player A as the winner of the bonus jackpot. A congratulatory message appears on Player A's screen, and the current jackpot amount is credited to their account instantly, while Player B continues playing. The event creates an unexpected thrill that boosts engagement.

Player Interaction: Players interact with the random bonus jackpot passively, as their primary activity remains the specific game. However, the knowledge that a bonus may be triggered at any time encourages prolonged gameplay and higher engagement. Players are kept informed through dynamic display elements, which show the current jackpot amount and announce when a jackpot is awarded. The randomness and unpredictability of the feature differentiates it from standard jackpots that are tied to specific gameplay outcomes or bet amounts.

Distinguishing Innovative Concepts: This concept distinguishes itself by introducing a purely random trigger for a bonus jackpot, which is independent of player actions, game outcomes, or wager size. Traditional DETGs typically link jackpot triggers to specific events, such as a player obtaining a particular hand or placing a side bet. The Random Event Generator adds an element of surprise, increasing player engagement by offering the potential for spontaneous rewards.

Another distinguishing factor is the integration with the casino's Player Tracking System, which ensures that only active participants are eligible, even if their current game outcome is unfavorable.

### Distinguishing Inventive Steps

1. Random Trigger Activation: The RNG generates random intervals to trigger the bonus jackpot, independent of game outcomes or player wagers.
2. Immediate Jackpot Notification: Once triggered, the system instantly informs players across all connected ETGTs through visual and auditory cues.
3. Random Winner Selection: The system randomly selects one eligible player to receive the bonus, regardless of their current game performance.

These steps introduce randomness and spontaneity into the gameplay, driving higher player engagement and making the gaming experience more dynamic compared to prior art.

35 USC 101 Considerations: This concept provides a technical solution to enhancing player engagement by introducing a random event-triggered jackpot, which goes beyond mere abstract ideas of traditional jackpot systems. The integration of an RNG for triggering the jackpot and the dynamic interaction between the Casino Network Server and ETGTs demonstrates an improvement in computer functionality and game system architecture. The random bonus feature creates a unique method of awarding jackpots, adding to the practical application of game management in live casino environments.

Data Input: The system continuously collects data from player terminals, including wagering activity and time spent in-game. These inputs are used by the RNG and Player Tracking System to determine player eligibility and to randomly trigger the jackpot.

### Component Interactions and Procedural Steps

1. Players place their wagers through ETGTs.
2. The Random Event Generator runs in the background, processing random intervals and game data.
3. Upon meeting the random trigger condition, the system sends notifications to all ETGTs.
4. The Casino Network Server processes the jackpot trigger and selects a random winner from eligible players.
5. The system credits the jackpot amount to the winner's account and resets for the next round.

Data Processing: The system processes random intervals, player participation data, and jackpot amounts to determine when the jackpot should be triggered and who the eligible players are. This ensures fairness and prevents any manipulation of the jackpot conditions.

Outputs and Responses: When the random bonus jackpot is triggered, the system generates visual and auditory alerts on the ETGT displays, notifying all players of the event. The winner receives an immediate credit to their balance, and other players are encouraged to continue playing, knowing that the next random bonus may trigger at any time.

Data Storage and Reporting: Jackpot trigger events and player eligibility data are stored in the casino's central database for reporting and auditing purposes. This ensures transparency in the jackpot awarding process and provides the casino with detailed records of random bonus activations.

Error Handling and Security Measures: The system ensures that the RNG operates correctly, and security protocols are in place to prevent tampering with the random jackpot trigger. If an error occurs, such as a miscommunication between the Casino Network Server and ETGTs, the system halts the jackpot trigger and notifies administrators for investigation.

End of Interaction: Once the random bonus is awarded, the system resets for the next random event, and players continue their regular gameplay without interruption. The jackpot pool may increment again based on ongoing player participation.

### Innovative Concept 74—Dynamic Jackpot Display

Identification of Concept: This concept centers around a dynamically updating display that shows current jackpot amounts, odds of winning, and the countdown to the next potential random jackpot trigger. The Dynamic Jackpot Display adds visual engagement to the gameplay, continuously updating jackpot metrics in real-time. This feature may be integrated into DETGs to enhance player anticipation, providing notable information that keeps players informed and engaged. The visual representation of jackpot data may include animations, countdown timers, and other real-time feedback mechanisms that draw players' attention and incentivize continuous participation.

### Sequence Diagram Components

1. Electronic Table Game Terminal (ETGT): Displays real-time jackpot information, including current prize amounts, odds of winning, and countdowns to jackpot events.
2. Dynamic Display Module: A software component integrated into the DETG system, responsible for visualizing jackpot metrics on player screens.
3. Player A & Player B: Players interacting with the display and using the information to guide their betting strategy.
4. Casino Network Server: Receives jackpot data and transmits real-time updates to the Dynamic Display Module.
5. Jackpot Management System: Calculates the odds of winning, monitors the jackpot pool, and sends this data to the Dynamic Display Module for visual representation.
6. Player Tracking System: Ensures that only active, eligible players see relevant jackpot information.

Implementation Details: The Dynamic Jackpot Display may be implemented by adding a software layer to the DETG system that integrates real-time jackpot data into the game interface. This software communicates with the Casino Network Server to receive updates on jackpot contributions, odds of winning, and the timing of random triggers. Each ETGT may include a dedicated section of the screen where this information is displayed, allowing players to monitor the progress of the jackpot without interrupting gameplay.

The visual elements of the display may include color-coded progress bars, jackpot growth animations, and countdown timers that signal the approach of important events like random jackpot triggers. Additionally, the Dynamic Display Module may include personalized messages for players who are eligible for jackpots, further enhancing the customized experience.

Example Walk-through Scenario: Player A and Player B are playing a round of roulette on a DETG system. As they place their bets, the Dynamic Jackpot Display on their terminals updates to show the current jackpot amount, which has been increasing steadily with contributions from other players. A progress bar indicates the countdown to the next random jackpot trigger, which is set to occur within the next 10 minutes.

Both players are drawn to the information, and Player A increases their wager, hoping to qualify for the upcoming jackpot. The display also shows that Player B's current odds of winning the jackpot are 5%, based on their recent activity and wager size. This real-time feedback drives both players to remain engaged and continue playing in anticipation of the jackpot event.

Player Interaction: Players interact with the Dynamic Jackpot Display passively while focusing on the main game. The constantly updating jackpot information serves as a motivator, influencing their betting behavior. For instance, a player may increase their wager when they see the jackpot nearing a trigger event or notice that their odds of winning have improved. The dynamic nature of the display keeps the game visually engaging and informative.

Distinguishing Innovative Concepts: Traditional DETGs provide static information regarding jackpots, often only showing the current amount without additional context. This concept introduces a continuously updating display that informs players of the evolving jackpot metrics in real-time. The integration of countdowns, odds, and personalized messages creates a more immersive experience that goes beyond the basic functionality of conventional displays. Additionally, the countdown timer feature heightens anticipation, especially during peak gameplay periods.

### Distinguishing Inventive Steps

1. Real-time Jackpot Updates: The Dynamic Display Module continuously pulls data from the casino server to update jackpot amounts and player odds in real-time.
2. Countdown Timer: Displays a visual countdown to important jackpot events, such as random trigger points, increasing player anticipation.
3. Personalized Display Elements: Custom messages and odds tailored to each player's activity are shown, enhancing engagement and encouraging higher wager participation.

These inventive steps differentiate the display from conventional systems by adding dynamic and personalized elements that react to player behavior and game conditions.

35 USC 101 Considerations: This concept improves the functionality of DETGs by integrating a Dynamic Display Module that provides real-time, personalized feedback to players. The display of evolving jackpot metrics and odds addresses a technical problem in live casino gaming by keeping players informed and engaged, which enhances the overall experience. The inclusion of countdown timers and dynamic visual elements creates a specific improvement in how jackpot data is presented to players, elevating the system's practical application.

Data Input: The system processes ongoing player activity, wager amounts, and real-time jackpot contributions.

It also collects time-based inputs for the countdown feature and calculates player-specific odds based on their contributions and game history.

### Component Interactions and Procedural Steps

1. Players place wagers through ETGTs.
2. The Casino Network Server calculates jackpot amounts and player odds.
3. The Dynamic Display Module updates the display in real-time, showing jackpot data and countdowns.
4. The Jackpot Management System processes player contributions and sends data to the server.
5. The display reacts dynamically to changes in jackpot conditions, providing feedback to players.

Data Processing: The system processes data from player wagers, jackpot contributions, and random trigger timers to ensure the information displayed is accurate and up-to-date. The odds of winning and countdown timers are calculated based on player participation and game events.

Outputs and Responses: The Dynamic Jackpot Display outputs real-time updates on jackpot conditions, including current amounts, player odds, and event countdowns. This information is visualized on the player's terminal, providing them with valuable feedback that influences their gameplay decisions.

Data Storage and Reporting: The system stores historical jackpot data, including contributions and payouts, in the casino's database. This data is used for reporting purposes and to track player engagement with the jackpot system.

Error Handling and Security Measures: Error handling mechanisms ensure that jackpot data is displayed accurately and that updates occur in real-time. Security protocols are in place to prevent tampering with jackpot calculations or player odds.

End of Interaction: Once a jackpot event occurs, the display resets, and the countdown starts again for the next jackpot trigger. Players continue playing without interruption, with new data continuously updating on their screens.

### Innovative Concept 75—Time-Based Jackpot Contribution Limits (Alternative Version)

Identification of Concept: This innovative concept introduces a time-limited window during which players may contribute to the jackpot pool. Players must place wagers within a specific timeframe, after which the jackpot pool closes for that round. This creates a sense of urgency, encouraging players to place higher bets during the contribution window. The time-based contribution limits may be implemented in Live Dealer Electronic Game Table Systems (DETGs) to regulate when and how players contribute to the jackpot, enhancing excitement and driving higher participation during notable gameplay periods.

### Sequence Diagram Components

1. Electronic Table Game Terminal (ETGT): Tracks player wagers and enforces the time-based contribution limit.
2. Player A & Player B: Represent multiple players contributing to the jackpot within the allowed timeframe.
3. Timer Module: A software component that tracks the time window for jackpot contributions and enforces limits.
4. Jackpot Pool Manager: Manages the accumulation of jackpot contributions and closes the pool once the time limit is reached.
5. Casino Network Server: Coordinates communication between ETGTs and the Jackpot Pool Manager to ensure contributions are correctly recorded within the timeframe.
6. Random Number Generator (RNG): Ensures that jackpot payouts occur fairly after the contribution window closes.

Implementation Details: This concept may be implemented by integrating a Timer Module into the DETG system, which opens a contribution window at the start of each game round. Players are informed of the time remaining to place bets that contribute to the jackpot pool. Once the timer expires, no further contributions are allowed for that round, and the Jackpot Pool Manager locks in the total contributions. This creates a heightened sense of urgency and competition among players, as they are encouraged to place larger wagers within the limited timeframe to maximize their jackpot participation.

The Casino Network Server plays a notable role in synchronizing the contribution window across all ETGTs, ensuring that each player receives real-time updates on the remaining time to contribute. Once the window closes, the server calculates the final jackpot pool and prepares the system for the next round.

Example Walk-through Scenario: Player A and Player B are playing a DETG baccarat game with a time-limited jackpot contribution system. At the start of the round, the Timer Module activates, and both players are notified that they have 60 seconds to place their bets if they wish to contribute to the jackpot pool. Player A quickly places a higher bet to maximize their contribution, while Player B hesitates and places a smaller wager as the timer ticks down.

Once the timer expires, the Jackpot Pool Manager closes the pool for that round, and the jackpot amount is locked in. Both players are informed that no further contributions will be accepted until the next round begins. The game continues, with both players anticipating the jackpot outcome based on their contributions.

Player Interaction: Players interact with the time-limited jackpot contribution system by placing bets within the specified window. The countdown timer displayed on their ETGTs adds urgency, encouraging faster and higher bets. Players are motivated to act quickly to ensure their participation in the jackpot pool before the contribution window closes.

Distinguishing Innovative Concepts: Unlike traditional jackpots where contributions are accepted throughout the game, this concept introduces a time-limited contribution system, creating a unique sense of urgency. The Timer Module ensures that players must act within a specific window to participate, adding a layer of strategic decision-making that is absent from conventional DETG systems. This time-based mechanism distinguishes the concept by regulating how and when players contribute to the jackpot, driving higher participation during peak gameplay moments.

### Distinguishing Inventive Steps

1. Time-Limited Contribution Window: The Timer Module opens and closes the jackpot pool within a fixed timeframe, creating urgency for players to place their bets.
2. Real-Time Notifications: Players are notified of the remaining time to contribute, influencing their wagering behavior.
3. Locked Jackpot Pool: Once the contribution window closes, the Jackpot Pool Manager locks the pool, and no further contributions are accepted for that round.

These steps create a time-sensitive environment that incentivizes quick decision-making and larger bets, differentiating it from traditional jackpot systems where contributions are accepted continuously.

35 USC 101 Considerations: This concept offers a specific improvement in how jackpot contributions are managed within a DETG system by introducing time-limited contribution windows. The Timer Module and Jackpot Pool Manager provide a practical application that enhances player engagement by adding a strategic element to jackpot contributions. This technical solution goes beyond abstract ideas by integrating time-based mechanics that improve the functionality of DETGs, creating a more dynamic and competitive gaming experience.

Data Input: The system processes player wagers and the time remaining in the contribution window. Players input their bets through ETGTs, and the Casino Network Server ensures that contributions are recorded within the allowed timeframe.

### Component Interactions and Procedural Steps

1. Players place wagers through ETGTs.
2. The Timer Module activates, displaying the countdown for jackpot contributions.
3. The Casino Network Server tracks player bets and updates the jackpot pool.
4. The Jackpot Pool Manager closes the pool when the timer expires, locking in the contributions for that round.

Data Processing: The system processes player bets in real-time, calculating the total jackpot contributions before the window closes. The Jackpot Pool Manager ensures that no further contributions are accepted once the time limit is reached, providing a final tally for the round.

Outputs and Responses: The system outputs real-time notifications to players, informing them of the remaining time to contribute. Once the contribution window closes, the system locks the jackpot pool and displays the final amount to all players.

Data Storage and Reporting: Contribution data for each round is stored in the casino's central database for auditing and reporting purposes. This ensures transparency in the jackpot process and allows the casino to track player participation.

Error Handling and Security Measures: The system ensures that contributions are accurately recorded within the allowed timeframe. Security protocols are in place to prevent tampering with the contribution window or the jackpot pool.

End of Interaction: Once the contribution window closes, the system locks the jackpot pool, and players must wait for the next round to contribute again. The countdown timer resets for the next game, ensuring a seamless transition between rounds.

### Innovative Concept 76—Randomized Player Eligibility

Identification of Concept: This innovative concept involves assigning jackpot eligibility to players randomly at the start of each gaming session. Not all players are eligible for the jackpot in every game session, and eligibility is randomly determined by the system. This concept introduces an additional element of surprise and excitement, as players may or may not be eligible for the jackpot based purely on chance, regardless of their wagering amounts or VIP status. This system may be implemented in Live Dealer-Controlled Multiplayer Games and DETGs to create unpredictability and boost player engagement by offering exclusive jackpot participation that varies with each session.

### Sequence Diagram Components

1. Electronic Table Game Terminal (ETGT): Communicates eligibility status to the player at the beginning of each game session.
2. Player A & Player B: Players who are randomly assigned eligibility for the jackpot at the start of a session.
3. Random Eligibility Generator: A software component responsible for assigning eligibility at random intervals or upon a session's start.
4. Casino Network Server: Manages eligibility data and communicates updates to each ETGT.
5. Player Tracking System (PTS): Ensures that each eligible player is tracked, and eligibility data is stored.
6. Jackpot Manager System: Processes jackpot trigger events and cross-checks with the eligibility of participating players before awarding the prize.

Implementation Details: The Random Eligibility Generator may be integrated into the specific game software of the DETG system. At the start of each session or at predefined intervals, this module randomly assigns jackpot eligibility to players. This eligibility may be reflected on the player's screen via a notification or indicator. Implementation may require the Casino Network Server to manage the assignment process, ensuring fairness by relying on a Random Number Generator (RNG) to determine who qualifies for the jackpot.

The Player Tracking System stores data on eligibility, which may be accessed by the Jackpot Manager System when a jackpot trigger event occurs. This ensures that only eligible players may win the jackpot, even if all players are participating in the game. Eligibility is typically session-based, meaning that a player's eligibility status may change with each session, encouraging players to keep playing to increase their chances.

Example Walk-through Scenario: Imagine Player A and Player B are seated at a DETG roulette table. When they log into the game, the system's Random Eligibility Generator activates, determining that Player A is eligible for the jackpot in this session, while Player B is not. Player A receives a notification on their screen: “You are eligible for the mystery jackpot this session!” while Player B receives no such message.

As the session progresses, the jackpot is triggered. The Jackpot Manager System cross-checks the eligibility status of both players and determines that only Player A may win the jackpot. If Player A's bet qualifies them based on the jackpot trigger conditions, they are awarded the prize. Player B continues playing without jackpot eligibility but may have a chance in the next session.

Player Interaction: Players are informed of their jackpot eligibility status at the start of each session, creating anticipation. Player A, who is eligible, may feel an increased sense of excitement and engagement, while Player B, who is ineligible, may still continue playing in hopes of becoming eligible in the next session. This randomness encourages repeated play sessions and introduces a unique player experience.

Distinguishing Innovative Concepts: This concept introduces randomized player eligibility as a notable differentiator from conventional DETG systems where all players are uniformly eligible for jackpots. By adding a randomized eligibility mechanic, it increases unpredictability and encourages players to participate in multiple sessions to maximize their chances of being eligible for the jackpot. This randomization also offers casinos a method of managing jackpot payout liabilities by limiting the number of eligible players at any given time.

### Distinguishing Inventive Steps

1. Randomized Eligibility Assignment: The system randomly determines which players are eligible for the jackpot at the beginning of each session.
2. Real-Time Eligibility Notification: Players are immediately informed of their eligibility status through notifications on their ETGT.
3. Cross-Check with Jackpot Trigger Events: The system verifies eligibility before awarding a jackpot, ensuring only those selected at random may win.

These steps distinguish the system by introducing a random element of exclusivity, where only certain players have access to jackpot rewards based on random chance rather than wager amounts or game outcomes.

35 USC 101 Considerations: This innovative concept improves the functionality of DETGs by adding a randomized eligibility mechanic that enhances player engagement. The concept integrates real-time player data with a Random Number Generator to offer a unique improvement in how jackpots are awarded. This randomness introduces unpredictability, providing a technical advancement over traditional jackpot systems where eligibility is determined uniformly or based on fixed criteria. The randomization feature creates a new method for dynamically managing jackpot participation, improving both the player experience and the casino's liability management.

Data Input: The system processes each player's session start, generating random eligibility for the jackpot. Player data is stored and used by the Player Tracking System to maintain accurate records of eligibility.

Component Interactions and Procedural Steps
1. Players log into the ETGT.
2. The Random Eligibility Generator assigns jackpot eligibility based on a random process.
3. The Casino Network Server tracks eligibility status and sends real-time updates to each player.
4. Upon a jackpot trigger, the system checks the eligibility of each player before awarding the jackpot.

Data Processing: The system processes player session data and uses a Random Number Generator to assign eligibility. This data is stored for the duration of the session, ensuring that only eligible players are considered for jackpot awards, and the jackpot is only awarded to those players who were randomly selected as eligible.

Outputs and Responses: The system outputs notifications on the ETGT screen at the start of each session to inform players whether they are eligible for the jackpot. If a jackpot trigger occurs, the system checks eligibility, and if an eligible player wins, a congratulatory message is displayed along with the jackpot amount being credited to their account.

Data Storage and Reporting: The eligibility status of each player is stored within the Casino Network Server for the duration of the session. The system also records which players were eligible and the jackpot outcomes, storing this data for reporting and auditing purposes.

Error Handling and Security Measures: The system ensures that eligibility assignment is random and secure, preventing any manipulation or favoritism in the selection process. If errors occur in the communication between the Random Eligibility Generator and the Casino Network Server, the system may log and report these issues for review. Any discrepancies in eligibility assignment are flagged for correction before the next session starts.

End of Interaction: Once the session concludes, all eligibility data is reset, and players must wait for the next session to see if they become eligible for the jackpot. The Random Eligibility Generator resets for each session, ensuring fairness across multiple gameplay rounds.

### Innovative Concept 77—Jackpot Triggered by Game Outcome Sequences

Identification of Concept: This innovative concept introduces a jackpot system that is triggered based on a specific sequence of game outcomes. For example, a jackpot may be awarded if the dealer wins five consecutive rounds in a card game, or if the same number lands on the roulette wheel multiple times in a row. This system is designed to add another level of excitement by rewarding players for observing patterns or sequences in the game. The sequence-based trigger may be implemented in Live Dealer-Controlled Multiplayer Games and DETGs to enhance player engagement and add variety to the jackpot mechanics.

### Sequence Diagram Components

1. Electronic Table Game Terminal (ETGT): Tracks player activity and informs them of potential jackpot trigger sequences based on game outcomes.
2. Player A & Player B: Players actively participating in the game, monitoring the outcome sequences to see if the jackpot is triggered.
3. Game Outcome Tracker: A software component that tracks game results and identifies when a qualifying outcome sequence occurs.
4. Casino Network Server: Manages communication between the Game Outcome Tracker and the ETGTs, ensuring all players are notified when the jackpot sequence is close to being triggered.
5. Jackpot Manager System: Verifies that the specific outcome sequence has occurred before awarding the jackpot to an eligible player.

Implementation Details: To implement this concept, the Game Outcome Tracker is integrated into the Live Dealer Electronic Game Table System (DETGs), which continuously monitors game outcomes and compares them against predefined sequences that trigger the jackpot. For example, in a live blackjack game, the system tracks consecutive wins by the dealer. Once the dealer wins five hands in a row, the Jackpot Manager System verifies the sequence and triggers a jackpot event.

The Casino Network Server communicates with the ETGTs to keep players updated on the current progress of the outcome sequence. If a qualifying sequence is in progress (e.g., four consecutive dealer wins), the system may display a notification on the ETGTs to build anticipation. When the sequence is completed, eligible players are notified that the jackpot has been triggered.

This implementation ensures that all players have access to the same information in real time, creating a competitive and engaging environment where everyone is invested in the outcome of the game. The system is configured to handle multiple game types, allowing for sequence-based jackpots in games like blackjack, roulette, or baccarat.

Example Walk-through Scenario: Player A and Player B are both participating in a live baccarat game via DETGs. The Game Outcome Tracker is set to trigger a jackpot if the banker wins five rounds in a row. After the third consecutive banker win, both players notice a notification on their ETGT screens: “3 Wins in a Row! 2 More for the Jackpot!”

Excitement builds as both players continue placing their bets. The fourth and fifth wins by the banker occur in quick succession, and the Jackpot Manager System triggers the jackpot. Player A, who had placed a higher bet and was eligible for the jackpot, wins the prize. Player B, despite participating in the game, did not meet the eligibility requirements due to a lower wager threshold and does not receive the jackpot.

Player Interaction: Players interact with this system by monitoring the outcome sequences displayed on their terminals. As sequences progress, players are motivated to continue betting, hoping that they will meet the eligibility criteria by the time the sequence completes. This concept encourages active participation in the game as players become more engaged when a potential jackpot is close.

Distinguishing Innovative Concepts: This concept is distinct because it ties jackpot triggers to a sequence of game outcomes rather than a single event, such as hitting a specific hand or making a particular wager. Traditional DETGs typically rely on individual game results or side bets to trigger jackpots. By introducing outcome sequences, the system encourages players to stay engaged across multiple rounds, increasing playtime and overall excitement.

Additionally, this feature adds a strategic layer to gameplay, where players may adjust their bets based on the progress of a sequence, making the experience more dynamic.

### Distinguishing Inventive Steps

1. Outcome Sequence Tracking: The system tracks game results and identifies when a specific sequence of outcomes has occurred, such as consecutive wins or repeating numbers in a game of roulette.
2. Real-Time Notifications: The system notifies players of the current sequence progress, encouraging them to stay engaged as they anticipate a jackpot trigger.
3. Jackpot Trigger Based on Sequences: Once the defined sequence of outcomes is achieved, the system triggers the jackpot, rewarding eligible players.

These steps differentiate the concept from conventional systems by focusing on sequences rather than isolated game results, creating a longer-term engagement strategy.

35 USC 101 Considerations: This concept provides a technical improvement over traditional jackpot systems by introducing a sequence-based trigger that enhances player engagement and excitement. The Game Outcome Tracker and the Jackpot Manager System work together to monitor game results and trigger jackpots based on predefined sequences, offering a novel approach to jackpot mechanics. This advancement integrates seamlessly into the DETG environment, solving the problem of stagnant engagement during prolonged gaming sessions by adding variability and anticipation to the jackpot process.

Data Input: The system collects data on each game result, including dealer wins, player wins, or specific game outcomes (e.g., a particular number on the roulette wheel). This data is processed in real time to determine if a qualifying sequence is in progress.

### Component Interactions and Procedural Steps

1. The game begins, and players place their bets on the ETGT.
2. The Game Outcome Tracker records the result of each round, looking for specific sequences of outcomes (e.g., five consecutive dealer wins).
3. When a sequence progresses, the system sends real-time updates to the players' ETGTs, displaying the sequence status.
4. If the sequence completes, the Jackpot Manager System triggers the jackpot and distributes it to eligible players.
5. The system resets the sequence counter, and the game continues.

Data Processing: The system processes the outcome of each round in real time, comparing it against the predefined sequences that trigger the jackpot. It also calculates player eligibility based on their wager amounts and contributions, ensuring that only those who qualify receive the jackpot.

Outputs and Responses: Players receive real-time notifications of sequence progress on their ETGT displays. When the jackpot is triggered, eligible players are notified of their win, and the jackpot amount is credited to their accounts. The system also resets the sequence tracking for the next game.

Data Storage and Reporting: The system stores outcome sequence data, jackpot triggers, and player eligibility information in the casino's database. This data may be used for auditing, reporting, and analyzing player engagement trends.

Error Handling and Security Measures: The system ensures the integrity of sequence tracking by using secure communication protocols between the Game Outcome Tracker and the Casino Network Server. If an error occurs, such as a discrepancy in the sequence count, the system flags it for investigation and halts the jackpot trigger until the issue is resolved.

End of Interaction: Once the jackpot is triggered based on the outcome sequence, the system resets, and a new sequence begins tracking in the next round. Players may continue participating, knowing that another sequence-based jackpot may be triggered at any time.

### Innovative Concept 78—Progressive Jackpot Contribution for Specific Hands

Identification of Concept: This innovative concept introduces the idea of contributing extra amounts to a progressive jackpot pool based on specific hands in card games. For example, in blackjack, hands such as a Royal Flush or a Blackjack with suited cards may trigger an additional contribution to the jackpot pool, increasing its size more quickly. This system rewards players with unique hands by allowing their contributions to have a greater impact on the overall jackpot. It may be implemented in Live Dealer-Controlled Multiplayer Games and DETGs, where specific hand combinations add a fixed or percentage-based amount to the jackpot.

### Sequence Diagram Components

1. Electronic Table Game Terminal (ETGT): Displays the special hand combinations that contribute extra to the jackpot pool and tracks player hands.
2. Player A & Player B: Players participating in the game whose hands may trigger extra contributions based on specific card combinations.
3. Hand Recognition Module: A software component that recognizes specific hands (e.g., Royal Flush) and calculates the additional contribution to the jackpot.
4. Jackpot Pool Manager: Manages the total jackpot pool and updates it when special hand contributions are made.
5. Casino Network Server: Communicates with the ETGTs and Hand Recognition Module to ensure accurate contribution tracking.

Implementation Details: This concept may be implemented by integrating a Hand Recognition Module into the DETG system, which identifies specific card combinations that trigger additional contributions to the jackpot pool. For example, if a player receives a Royal Flush in a poker game or a Blackjack with suited cards in blackjack, the system automatically calculates an extra contribution and adds it to the jackpot.

The Jackpot Pool Manager tracks the total contributions and updates the jackpot display in real time. The system may be configured to allow fixed amounts or percentages of the player's wager to be contributed, depending on the hand's rarity. Notifications on the ETGT inform players when they've contributed extra to the jackpot due to their special hand, adding excitement and encouraging more strategic play.

Example Walk-through Scenario: Player A and Player B are playing a live blackjack game. During the game, Player A receives a Blackjack with suited cards, which is a special hand recognized by the system as triggering an additional contribution to the progressive jackpot. The Hand Recognition Module identifies the suited blackjack and immediately calculates an extra contribution to the jackpot pool based on a percentage of Player A's wager. The Jackpot Pool Manager updates the total jackpot amount, and Player A's terminal displays a message: “Suited Blackjack! Extra Contribution Added to the Jackpot!”

Player B, observing this event, is motivated to continue playing in hopes of landing their own special hand to contribute extra to the jackpot. As the game progresses, these special hand triggers not only increase the jackpot pool but also drive excitement and engagement across all participating players.

Player Interaction: Players interact with this feature passively through their card hands. If they are dealt a qualifying hand, such as a Royal Flush in poker or a suited Blackjack, their contributions to the jackpot pool automatically increase. Players are incentivized to aim for these rare hands, adding a layer of excitement and strategy to the game. The system rewards players for obtaining special hands by publicly recognizing their contribution to the jackpot pool, which further motivates engagement.

Distinguishing Innovative Concepts: This concept is distinct because it ties jackpot contributions to specific card combinations, rewarding players for obtaining rare hands rather than just focusing on traditional side bets or game outcomes. Unlike standard progressive jackpots where contributions are uniform, this system allows players with lucky hands to have a more significant impact on the jackpot growth. This additional mechanic makes the game more dynamic and rewards individual player skill or luck, increasing the excitement of hitting these rare hands.

### Distinguishing Inventive Steps

1. Hand-Based Jackpot Contributions: The system identifies specific hands that trigger an extra contribution to the progressive jackpot, linking contributions to in-game skill or luck.
2. Real-Time Jackpot Updates: When a special hand occurs, the jackpot is updated instantly, and the player is notified of their additional contribution.
3. Enhanced Jackpot Growth: The progressive jackpot grows faster due to the additional contributions triggered by special hand combinations, making it more attractive to players.

These steps introduce a new way for players to interact with the jackpot system, as the jackpot is influenced by the quality of their hands rather than just wager amounts or random events. This increases engagement by providing players with a tangible goal (obtaining specific hands) that impacts the game's larger mechanics.

35 USC 101 Considerations: This innovative concept provides a technical improvement by incorporating a Hand Recognition Module that automatically detects specific card combinations and dynamically adjusts the progressive jackpot contributions. This approach solves the problem of static jackpot growth by introducing variability based on in-game hands, adding depth to the gameplay and rewarding players for achieving certain outcomes. The concept integrates this mechanic into the casino network and game server architecture, demonstrating a clear practical application that enhances the gaming experience.

Data Input: The system processes each player's hands, scanning for specific combinations that trigger additional contributions. Player wagers and hand results are collected in real-time and cross-referenced with the jackpot contribution rules.

### Component Interactions and Procedural Steps

1. Players place their bets, and the game begins.
2. The Hand Recognition Module analyzes each hand dealt to the players.
3. When a special hand is identified, the system calculates the extra contribution to the jackpot pool.
4. The Jackpot Pool Manager updates the jackpot amount in real time and sends notifications to the players involved.
5. The system resets after each hand, ready to recognize the next qualifying hand.

Data Processing: The system processes player hands in real-time, calculating the additional jackpot contributions based on predefined rules for special hands. It also ensures that the contribution is proportionate to the player's wager and updates the jackpot pool accordingly.

Outputs and Responses: Players receive immediate notifications on their terminals when they contribute extra to the jackpot due to a special hand. The Jackpot Pool Manager adjusts the displayed jackpot amount in real-time, ensuring that all players see the current value as it grows.

Data Storage and Reporting: The system logs all special hand occurrences, contributions to the jackpot, and jackpot growth over time. This data is stored for reporting, auditing, and analysis purposes, allowing the casino to track the impact of the special hand mechanic on jackpot growth and player engagement.

Error Handling and Security Measures: The system ensures that the Hand Recognition Module accurately identifies qualifying hands and calculates contributions correctly. If an error occurs, such as misidentifying a hand, the system flags it for review, and no contributions are added until the issue is resolved.

End of Interaction: Once the special hand contribution is processed and the jackpot is updated, the system resets for the next round of gameplay. Players continue playing with the potential to trigger additional contributions in future hands.

### Innovative Concept 79—Multi-Game Linked Jackpot

Identification of Concept: This concept introduces a progressive jackpot that is linked across multiple live dealer-controlled games and DETG systems. Rather than restricting the progressive jackpot to a single game type or table, the Multi-Game Linked Jackpot concept enables a shared jackpot pool across several different games, such as blackjack, baccarat, and roulette. This allows players from various games to contribute to and be eligible for the same jackpot, significantly increasing the jackpot's size and frequency of payouts. The system tracks contributions from all linked games and distributes the jackpot to eligible players, regardless of the game they are playing. This concept may be implemented in Live Dealer Electronic Game Table Systems (DETGs), where multiple tables and game types are interconnected to contribute to the same jackpot pool.

### Sequence Diagram Components

1. Electronic Table Game Terminal (ETGT): Used by players in different games, contributing to the same jackpot pool.
2. Player A & Player B: Represent players participating in different games, both contributing to and eligible for the same multi-game jackpot.
3. Jackpot Pool Manager: Tracks contributions from all linked games, updates the jackpot pool in real-time, and triggers the jackpot across all games when appropriate.
4. Casino Network Server: Manages communication between different games, ensuring that all contributions are accurately pooled and jackpots are correctly distributed to eligible players.
5. Player Tracking System (PTS): Tracks player participation and wager amounts across multiple games to ensure eligibility for the jackpot.
6. Game Servers (e.g., Blackjack Server, Baccarat Server, Roulette Server): Manage individual games and communicate game data, including contributions to the jackpot, with the Casino Network Server.

Implementation Details: The Multi-Game Linked Jackpot may be implemented by connecting the jackpot systems of various games (e.g., blackjack, baccarat, roulette) through the Casino Network Server. The Jackpot Pool Manager aggregates contributions from all games and ensures that the jackpot pool grows dynamically based on player participation across these different games. Each ETGT is connected to the system and tracks the player's contributions, regardless of which game they are playing at the moment.

The system may be configured so that players only become eligible for the jackpot after meeting a minimum wager threshold or specific game-related criteria. Once a jackpot-triggering event occurs (e.g., a player hitting a special hand in blackjack or landing a specific number in roulette), the Jackpot Pool Manager distributes the prize to the eligible player or players. Notifications are sent across all linked games to inform other participants of the jackpot win, creating excitement and encouraging continued play.

Example Walk-through Scenario: Player A is playing baccarat on a DETG, while Player B is playing blackjack at a different table, both contributing to the same linked progressive jackpot. Each player places their bets, and a portion of these bets is automatically added to the shared jackpot pool managed by the Jackpot Pool Manager.

As the games progress, Player B lands a blackjack with a special combination (e.g., suited blackjack), which triggers the jackpot. The Jackpot Pool Manager verifies that Player B has met the eligibility criteria and awards them the progressive jackpot, which had contributions from both Player A's baccarat game and Player B's blackjack game. The jackpot win is displayed across all connected ETGTs, including Player A's, encouraging further participation.

Player Interaction: Players from different games interact with the system by placing their wagers as usual, with a portion of each wager contributing to the shared jackpot pool. Players are informed that they are participating in a multi-game jackpot system and may win the jackpot regardless of which game they are playing. The shared jackpot pool creates excitement across multiple tables, encouraging players to continue playing, knowing that their contributions are part of a larger, multi-game event.

Distinguishing Innovative Concepts: This concept is distinct from traditional DETG systems, where jackpots are typically tied to individual games. By linking multiple games together under a single jackpot pool, this system creates a more substantial and rapidly growing jackpot, offering a higher level of excitement and engagement across various game types. This Multi-Game Linked Jackpot enables players from different tables and games to participate in the same jackpot, fostering a sense of shared competition and enhancing the overall casino experience. Additionally, it allows the jackpot pool to grow faster due to contributions from multiple sources, increasing the frequency and size of payouts compared to single-game progressive jackpots.

The system also distinguishes itself by promoting cross-game participation. Players may switch from one game to another while still contributing to and being eligible for the same jackpot, providing flexibility and encouraging longer play sessions across multiple games.

### Distinguishing Inventive Steps

1. Multi-Game Contribution Pooling: Contributions from multiple games (e.g., blackjack, baccarat, roulette) are pooled together into a single progressive jackpot, allowing players from different games to increase the jackpot simultaneously.
2. Cross-Game Jackpot Trigger: A jackpot may be triggered by a game-specific event (e.g., a special hand in blackjack or a specific number in roulette), regardless of which game the player is participating in, making all players eligible for the same jackpot.
3. Cross-Game Notifications: When the jackpot is won, notifications are sent to players in all participating games, creating excitement and encouraging further gameplay.

These inventive steps introduce a more integrated and engaging approach to progressive jackpots, promoting shared experiences across different games. This increases engagement by making the jackpot more accessible to players regardless of their game preferences.

35 USC 101 Considerations: This innovative concept improves the functionality of Live Dealer Electronic Game Table Systems (DETGs) by introducing a linked, multi-game jackpot system. It provides a technical solution to the challenge of stagnant jackpot growth by allowing contributions from multiple games, increasing the jackpot's size more rapidly and enhancing player engagement. The integration of the Jackpot Pool Manager with multiple game servers and real-time player tracking ensures that this concept has a clear, practical application that improves both the player experience and casino operations.

The multi-game linked jackpot concept also enhances the underlying game mechanics by providing a system that dynamically tracks contributions and eligibility across different games, offering a distinct improvement in how progressive jackpots are managed in a casino setting.

Data Input: The system collects real-time data from players across multiple games, including wager amounts, game outcomes, and player contributions. It also tracks which players are eligible for the jackpot based on game-specific criteria and wager thresholds.

### Component Interactions and Procedural Steps

1. Players place wagers across different games, such as blackjack, baccarat, or roulette, through their ETGTs.
2. A portion of each wager is contributed to the Multi-Game Linked Jackpot.
3. The Casino Network Server coordinates data from each game server, updating the Jackpot Pool Manager with the latest contributions.
4. The Jackpot Pool Manager monitors the jackpot pool and determines when a qualifying event triggers the jackpot (e.g., a special hand in blackjack).
5. The system checks for player eligibility before awarding the jackpot.
6. Once the jackpot is awarded, notifications are sent to all participating games, and the jackpot pool is reset for the next round of contributions.

Data Processing: The system processes real-time player contributions from multiple games and calculates the total jackpot pool. It also tracks player activity across different games to ensure that only eligible players may win the jackpot. The system calculates jackpot triggers based on specific game events and ensures that the correct player is awarded the jackpot when the criteria are met.

Outputs and Responses: When the jackpot is triggered, the system outputs a real-time notification to all participating games, displaying the jackpot win across all connected ETGTs. The jackpot amount is credited to the winning player's account, and the system resets the jackpot pool for future contributions.

Data Storage and Reporting: The system stores data on player contributions, game outcomes, and jackpot triggers in the casino's central database. This data is used for auditing, reporting, and analyzing the performance of the multi-game jackpot system, providing insights into player engagement and jackpot growth.

Error Handling and Security Measures: The system ensures that all contributions are accurately tracked and that the jackpot is only awarded when a valid trigger event occurs. Security protocols are in place to prevent tampering with the jackpot pool or contribution calculations. If a discrepancy occurs, the system flags the error for review and temporarily halts the jackpot distribution process until the issue is resolved.

End of Interaction: Once the jackpot is awarded, the system resets the jackpot pool for the next round of contributions, and players continue participating across multiple games. The Jackpot Pool Manager ensures that the new jackpot pool starts accumulating as soon as the next round of wagers is placed, keeping the game flow seamless and the jackpot feature continuously active.

### Innovative Concept 80—Tiered Jackpot Levels Based on Player Contribution

Identification of Concept: This innovative concept introduces a tiered jackpot system where players contribute to different jackpot levels based on their wager amounts. Instead of contributing to a single progressive jackpot, players may qualify for multiple tiers, such as Bronze, Silver, and Gold, depending on their bet sizes or cumulative contributions over time. Each tier offers a different jackpot prize, with higher levels offering larger payouts. This system may be implemented in Live Dealer-Controlled Multiplayer Games and DETGs, where players are incentivized to place larger bets to qualify for higher-tier jackpots.

### Sequence Diagram Components

1. Electronic Table Game Terminal (ETGT): Tracks player wagers and determines their contribution tier based on bet amounts.
2. Player A & Player B: Players participating at different contribution levels, qualifying for various jackpot tiers.
3. Jackpot Pool Manager: Manages the separate pools for each jackpot tier (e.g., Bronze, Silver, Gold), calculating contributions and triggering payouts accordingly.
4. Casino Network Server: Tracks player contributions and communicates with the Jackpot Pool Manager to update the different jackpot levels.
5. Player Tracking System (PTS): Records player participation and tracks their eligibility for each jackpot tier.
6. Random Number Generator (RNG): Ensures fairness in triggering jackpots across the different tiers.

Implementation Details: To implement the Tiered Jackpot Levels, the system may be configured to categorize player contributions based on wager size or cumulative play over time. For example, small wagers may qualify for the Bronze tier, while larger wagers contribute to the Silver and Gold tiers. Each ETGT tracks the player's contributions and displays which tier they qualify for based on their current bets.

The Jackpot Pool Manager maintains separate pools for each tier, ensuring that contributions are accurately allocated to the correct jackpot level. When a jackpot is triggered, the system determines which tier the winning player qualifies for and awards the corresponding prize. Players are incentivized to place higher bets to move into the higher-tier jackpot levels, offering a more substantial payout.

Example Walk-through Scenario: Player A is placing small bets and qualifies for the Bronze jackpot tier, while Player B, who places larger bets, qualifies for the Silver tier. Both players continue contributing to their respective jackpot levels as they place bets during a blackjack game.

During the session, the Jackpot Pool Manager detects a qualifying event and triggers the jackpot. Player B, having contributed to the Silver tier, wins the Silver jackpot, which is larger than the Bronze tier that Player A was eligible for. This encourages Player A to consider placing higher bets in future rounds to qualify for the higher-tier jackpots.

Player Interaction: Players are continuously informed of their contribution tier via the ETGT display, encouraging them to place larger bets to qualify for higher jackpot tiers. The system rewards players for their contributions, offering multiple jackpot levels to keep the game engaging for players of all betting sizes.

Distinguishing Innovative Concepts: This concept is distinct in that it offers multiple progressive jackpot levels based on player contributions. Traditional systems typically feature a single progressive jackpot pool, but this approach provides multiple tiers, allowing players with different betting strategies to participate in a jackpot system tailored to their contributions. The tiered structure introduces a scalable reward system, where players are motivated to wager more to access higher-tier jackpots, increasing overall player engagement and wager volume.

### Distinguishing Inventive Steps

1. Tiered Contribution System: Contributions are allocated to different jackpot pools (e.g., Bronze, Silver, Gold) based on player wager amounts or cumulative contributions.
2. Multiple Jackpot Pools: The system manages separate pools for each tier, ensuring that players are rewarded based on their contribution level.
3. Dynamic Tier Advancement: Players may progress to higher tiers as their wagers increase, encouraging them to place larger bets over time.

These steps introduce a differentiated jackpot system that offers scalable rewards based on player behavior, providing more personalized and tiered incentives compared to conventional single-pool jackpots.

35 USC 101 Considerations: This innovative concept introduces a clear improvement in the way jackpots are managed within DETGs by offering multiple tiers of rewards based on player contributions. The Tiered Jackpot Levels system enhances the functionality of traditional progressive jackpots by providing scalable rewards that adapt to player behavior, offering a practical application that increases player engagement and wager volume.

The system integrates a tiered approach to progressive jackpots, which is a novel and non-obvious method of managing player contributions and rewards within a live casino environment. By linking jackpot eligibility to wager sizes, the system provides a specific improvement in how jackpot systems operate in DETGs.

Data Input: The system collects data on each player's wager amount and categorizes contributions based on predefined tiers (e.g., Bronze, Silver, Gold). Player participation and eligibility data are tracked in real-time to ensure accurate jackpot pool allocation.

### Component Interactions and Procedural Steps

1. Players place wagers through their ETGTs.
2. The Electronic Table Game Terminal (ETGT) categorizes each player's wager into one of the predefined jackpot tiers (e.g., Bronze, Silver, Gold) based on the amount wagered.
3. The Casino Network Server tracks the player's contributions and updates the Jackpot Pool Manager with the amounts allocated to each tier.
4. The Jackpot Pool Manager maintains separate progressive pools for each jackpot tier and updates them in real time as players contribute.
5. When a jackpot event is triggered (e.g., through a special hand or random event), the Jackpot Pool Manager determines which tier the player qualifies for and awards the corresponding jackpot.
6. Notifications are sent to the player informing them of their win, while the jackpot pool for that specific tier is reset.
7. The system continues tracking player contributions for future jackpots, encouraging players to adjust their bets to access higher-tier pools.

Data Processing: The system processes real-time wagers from players across multiple games, determining the appropriate tier for each contribution based on predefined thresholds. The Jackpot Pool Manager calculates the total contributions for each jackpot tier and dynamically adjusts the jackpot amounts. When a jackpot event occurs, the system determines the player's tier, calculates the jackpot payout, and updates the remaining pool.

Outputs and Responses: Players receive real-time feedback on their contribution tier, including notifications when they qualify for a higher-tier jackpot or when a jackpot is triggered. The system outputs jackpot winnings directly to the player's account, with messages displayed on the ETGT to celebrate the win and inform the player of their contribution to the pool. Other players see a notification indicating that a jackpot has been won, encouraging further play.

Data Storage and Reporting: The system stores data on player wagers, tier progression, jackpot contributions, and payouts in the casino's central database. This information is available for reporting purposes, allowing the casino to track player participation, jackpot growth, and the performance of each tiered jackpot pool. The system may also generate analytics to measure player engagement and adjust thresholds for each tier based on player behavior.

Error Handling and Security Measures: The system incorporates error-handling mechanisms to ensure that contributions are accurately assigned to the correct jackpot tiers and that payouts are correctly processed. If any discrepancies in tier assignment or jackpot triggers are detected, the system halts the process and notifies administrators for manual review. Secure communication protocols prevent tampering with the tiered contribution system, ensuring fairness and transparency.

End of Interaction: Once a jackpot is triggered and awarded, the system resets the jackpot pool for that specific tier, allowing players to continue contributing. The player's contribution history and tier status are maintained for future games, and players are informed of their current tier status at the start of each new session. This process repeats, with the system dynamically adjusting tiered contributions based on real-time wagers, ensuring seamless transitions between rounds and jackpots.

### Innovative Concept 81—Mystery Jackpot Linked Across Multiple Game Types

### Identification of Concept:

This innovative concept involves linking a shared mystery jackpot pool across different game types in a live Dealer-controlled Electronic Table Games (DETGs) system. The notable feature is the integration of multiple game types such as blackjack, baccarat, and roulette, which all contribute to the same jackpot pool. Players participating in any of these games may have a chance to win the shared jackpot, with a portion of each player's wager contributing to the cumulative pool.

This concept may be implemented across DETGs by establishing a common jackpot server connected to each individual Electronic Table Game Terminal (ETGT), ensuring contributions from each different game type contribute to a unified jackpot pool. As DETGs may host a variety of games, the system would enable the same jackpot to be won regardless of the game type a player chooses, adding variety and cross-game excitement.

### Sequence Diagram Components:

The notable components involved in this implementation would include:
ETGT (Electronic Table Game Terminals): These are the individual terminals where players engage with various game types. Each terminal will track contributions and potential jackpot triggers.
Jackpot Server: This centralized system aggregates jackpot contributions from different game types and terminals, manages the jackpot pool, and determines the conditions under which the jackpot is triggered.
Casino Network: This manages communication between the ETGTs and the jackpot server, transmitting contribution data and verifying jackpot eligibility.
Players A, B, C: Each player may engage in a different game type, such as Player A playing blackjack, Player B playing baccarat, and Player C playing roulette.
Dealer: While dealers facilitate gameplay for each game type, their role in this context focuses on ensuring correct gameplay. Jackpot management is automated via the jackpot server.

### Implementation Details:

To implement this concept, each ETGT is configured with software that communicates with the central jackpot server, transmitting contribution data each time a player places a bet. The configuration for each terminal includes:
1. Game Type Integration: The DETG platform supports multiple game types (blackjack, baccarat, roulette) on the same network, with the contribution logic embedded into the wagering system for each game.
2. Contribution Mechanism: A predetermined percentage of the player's side bets in any game type contributes to the shared jackpot. This contribution mechanism is identical across all DETGs to maintain uniformity in jackpot growth.
3. Jackpot Eligibility Monitoring: The system monitors player wagers across multiple games. Any player, regardless of game type, becomes eligible to win the jackpot based on specific criteria (e.g., achieving a rare hand combination in blackjack or a three-card win in baccarat).
4. Cross-Game Communication: The system uses the casino's network infrastructure to track and synchronize contributions and updates across different game types.
5. User Interface: Jackpot contribution information is displayed on each ETGT, and a dynamic update system shows the growing jackpot amount in real-time, enhancing excitement.

### Example Walk-Through Scenario:

Consider a player named John sitting at a DETG playing blackjack, another player, Sarah, at a baccarat table, and a third player, Mike, playing roulette. Each player places their respective bets, with a portion of each bet being allocated to the shared jackpot pool.
1. John places a $100 bet in blackjack, contributing $1 to the shared jackpot.
2. Simultaneously, Sarah bets $200 in baccarat, contributing $2, and Mike places a $50 bet in roulette, contributing $0.50.
3. As each game progresses, the jackpot pool continues to grow, visible to all players across the different DETGs.
4. Eventually, Sarah wins a three-card baccarat hand, triggering a random chance at winning the jackpot. The central jackpot server calculates the jackpot, awarding the entire amount to Sarah.
5. Players in different games experience a thrilling moment as they witness the jackpot being won, with their contributions having fueled the prize pool.

### Player Interaction:

Players in different game types may interact with the jackpot system seamlessly. Whether a player is at a blackjack or baccarat terminal, they may track the jackpot's growth in real time on their respective terminal screens. Each player places their bets with the potential of contributing to and winning the shared mystery jackpot. Player engagement is further enhanced as they realize that any game they participate in may lead to a jackpot win, regardless of the game type.

### Distinguishing Innovative Concepts:

This concept differentiates itself from prior art through its integration across multiple DETG game types. Unlike conventional progressive jackpots limited to a single game type, this inventive system enables cross-game linking. The unified jackpot structure allows more dynamic player participation, encouraging engagement across multiple games. Additionally, the centralization of the jackpot through a shared server introduces an interconnected system across the DETGs, distinguishing it from standalone progressive systems.

### Distinguishing Inventive Steps:

1. Cross-Game Jackpot Pooling: Unlike traditional jackpots restricted to a single game type, this system pools contributions across multiple DETG games, creating a larger and more dynamic jackpot.
2. Real-Time Jackpot Growth Across Games: The system continuously updates and displays the jackpot across different game types, creating a synchronized player experience.
3. Randomized Jackpot Triggering Across Multiple Games: The randomness of jackpot triggers across various game types adds excitement, as any player in any game type may win at any time.

### 35 USC 101 Considerations:

This concept goes beyond a mere abstract idea by improving the functionality of gaming networks and enhancing player engagement. The integration of multiple DETG game types into a shared jackpot system is a technological improvement that solves the problem of limited player engagement in standalone jackpots. The cross-game jackpot system enhances the gaming experience by providing a shared objective that unites different player types. This system integrates into a practical application by allowing real-time, synchronized jackpot growth across different games, improving the casino's operational capabilities and increasing player retention.

### Data Input:

Players input their wagers in different game types (e.g., blackjack, baccarat, roulette), which are tracked by the DETGs. Each bet includes a small contribution to the mystery jackpot, and this data is transmitted to the central jackpot server for aggregation.

### Component Interactions and Procedural Steps:

1. Player A places a bet at a blackjack ETGT. The terminal sends wager information to the central jackpot server.
2. Player B plays baccarat. The baccarat ETGT communicates the contribution data to the server.
3. Player C plays roulette, contributing to the jackpot. The server updates the jackpot in real-time.
4. Jackpot server calculates contributions and distributes updates to all connected ETGTs.

### Data Processing:

The system processes real-time bet contributions from each DETG game type, updating the jackpot pool continuously. The jackpot server uses a randomization algorithm to determine when and where the jackpot will be triggered, ensuring fairness across different games.

### Outputs and Responses:

Each DETG displays the growing jackpot amount to all players in real-time. When a player wins the jackpot, the system broadcasts the event across all terminals, triggering celebratory animations and sound effects.

### Data Storage and Reporting:

The jackpot server stores all contributions and payout events in a secure database, allowing casino operators to review jackpot histories and player contributions.

### Error Handling and Security Measures:

Error-handling measures include verifying contribution data before updating the jackpot. The system also incorporates security protocols to prevent tampering or fraud in jackpot contribution and payout processes.

End of Interaction:

Once the jackpot is awarded, the system resets, initializing a new jackpot pool for the next round of contributions from multiple game types.

### Innovative Concept 82—Jackpot Opt-Out Mechanism

### Identification of Concept:

This innovative concept introduces a jackpot opt-out mechanism for players participating in DETG (Dealer-controlled Electronic Table Games) systems. The opt-out feature allows players to choose whether or not to contribute to a shared mystery jackpot pool while still participating in the specific gameplay. This level of player customization offers flexibility, appealing to players who may prefer to maximize their base game wagers without contributing to side bets.

In DETG systems, players at individual Electronic Table Game Terminals (ETGTs) are typically required to contribute to jackpot pools automatically. This innovative concept breaks away from that limitation by allowing each player to opt out during the game initiation phase. This may be done through a simple on-screen interface prompt before placing bets, giving players more control over their gambling experience.

### Sequence Diagram Components:

Notable components involved in this implementation include:
ETGTs (Electronic Table Game Terminals): Where players participate in DETG-based games and interact with the opt-out feature.
Player A and Player B: Players who interact with the opt-out mechanism. Player A opts into the jackpot pool, while Player B chooses to opt out.
Jackpot Server: Manages and tracks contributions to the shared jackpot pool and monitors which players have opted in or out.
Game Logic Processor: Embedded within the DETG system, the processor checks player opt-in status and calculates side bet contributions accordingly.
Casino Network: Facilitates communication between the ETGTs and the jackpot server.

### Implementation Details:

To implement the opt-out mechanism, each ETGT is enhanced with a user-friendly interface that gives players the option to contribute to the jackpot pool during the game's setup phase. Specific steps include:
1. Game Setup Interface: When players sit down at an ETGT, they are presented with a prompt asking if they would like to contribute to the jackpot. They may select “yes” or “no” via the touchscreen interface.
2. Custom Bet Configuration: If a player opts out, the game logic processor ensures their bets are not factored into the jackpot contributions. This adjustment occurs seamlessly, allowing the player to participate in the specific game without any side bet requirements.
3. Jackpot Server Synchronization: The jackpot server monitors all contributions and ensures that the bets of players who opt out are excluded from the jackpot pool calculation. The server tracks eligible players and ensures that only contributions from opted-in players count toward the jackpot.
4. Player Preferences Storage: The system may store player preferences for future games, streamlining the process for regular players who consistently opt out or in.

### Example Walk-Through Scenario:

1. Player A approaches a baccarat ETGT and selects to opt into the jackpot pool. They place a $100 wager with $2 contributing to the shared jackpot.
2. Player B, sitting at a different terminal playing the same game, chooses to opt out of the jackpot pool via the opt-out prompt. They also place a $100 wager, but none of their bet contributes to the jackpot.
3. The game proceeds normally, but Player A's contribution goes to the jackpot, while Player B's does not. Player B is still eligible for regular baccarat winnings, but they will not participate in any jackpot wins.
4. The jackpot server tracks Player A's contribution and excludes Player B's bet from the jackpot pool.

### Player Interaction:

Players interact with the opt-out mechanism directly through the DETG interface. Each player has the flexibility to decide whether or not to contribute to the jackpot pool before placing their bets. This feature offers players more control over their betting strategies, allowing them to customize their experience according to their preferences. The ability to opt out is particularly appealing to players who want to focus on base gameplay without additional side bet commitments.

### Distinguishing Innovative Concepts:

The opt-out mechanism differentiates itself by allowing customization in jackpot participation, which is not common in traditional systems. Conventional ETGs often automatically may require jackpot contributions from all players, but this invention gives players agency over their involvement. This increases player satisfaction by offering a tailored gaming experience.

### Distinguishing Inventive Steps:

1. Opt-In/Opt-Out Interface: Players are presented with a choice to opt in or out of the jackpot, offering a level of customization that is absent in conventional systems.
2. Real-Time Exclusion of Contributions: The system immediately recognizes a player's opt-out selection and excludes their bets from jackpot calculations.
3. Preference Retention for Future Sessions: Players may save their jackpot participation preferences for future sessions, streamlining the process and offering a more personalized gaming experience.

### 35 USC 101 Considerations:

This concept is patentable under 35 USC 101 because it improves the player experience in DETG systems by offering customization in jackpot participation, thus solving the problem of rigid, one-size-fits-all jackpot requirements. The opt-out mechanism is an improvement in computer functionality because it adds flexibility and complexity to the existing betting system, creating a more user-centric experience. It integrates into a practical application by giving players control over jackpot contributions and enhancing the overall enjoyment of casino gaming.

### Data Input:

The player inputs their opt-in or opt-out selection via the touchscreen interface at their ETGT. This data is sent to the game logic processor and jackpot server for further processing.

### Component Interactions and Procedural Steps:

1. Player A interacts with the opt-in prompt at their terminal. The system records their choice and sends the contribution data to the jackpot server.
2. Player B opts out, and the system excludes their contribution from jackpot calculations.
3. The jackpot server updates the current pool, ensuring only opted-in players' contributions are included.

### Data Processing:

The system processes the opt-in or opt-out decision and adjusts the jackpot calculations accordingly. For players opting out, the system excludes their bets from the jackpot pool while allowing them to continue playing the base game.

### Outputs and Responses:

The DETG displays confirmation of the player's selection, showing whether their bets will contribute to the jackpot pool. The system also ensures jackpot-related animations and notifications only appear for opted-in players.

### Data Storage and Reporting:

Player preferences for jackpot participation are stored for future reference, ensuring a smoother process for regular players. The jackpot server also stores data on which players contributed to the pool.

### Error Handling and Security Measures:

If a player encounters issues with the opt-in process, the DETG may display an error message prompting the player to reselect their preference. Additionally, secure encryption ensures that the opt-out mechanism is protected from tampering.

### End of Interaction:

Once the game session concludes, the system resets for the next round of players. Opt-in/opt-out selections may be stored for future sessions, reducing setup time for returning players.

### Innovative Concept 83—Baccarat-Specific Jackpot Triggers

### Identification of Concept:

This concept introduces jackpot triggers specific to baccarat gameplay. In baccarat, certain combinations, such as ties or three-card wins, may trigger jackpot contributions or even trigger the jackpot itself. By introducing these baccarat-specific triggers, the system enhances the excitement of playing baccarat while offering an additional layer of engagement through jackpot participation.

The system identifies specific game events unique to baccarat that will either contribute additional funds to the jackpot or trigger a potential payout. These events are tracked across all DETG terminals involved in baccarat, with contributions made toward a shared jackpot pool.

### Sequence Diagram Components:

The components involved in this concept include:
ETGTs: The terminals where players engage in baccarat and place their bets.
Jackpot Server: This tracks contributions to the jackpot pool and monitors specific baccarat outcomes (e.g., ties or three-card wins) to determine whether they trigger jackpot events.
Casino Network: Facilitates real-time communication between the ETGTs and the jackpot server.
Player A, Player B: Players participating in baccarat via DETG terminals, whose game outcomes may trigger jackpot contributions or winnings.
Dealer: While not directly involved in jackpot management, the dealer's actions during gameplay may influence the game's flow and potential jackpot triggers.

### Implementation Details:

For implementing baccarat-specific jackpot triggers, the ETGTs and the jackpot server are programmed to monitor specific game events and outcomes unique to baccarat. This process includes:
1. Baccarat Outcome Monitoring: The system tracks all game outcomes, identifying specific conditions such as ties or three-card wins, which are programmed to trigger jackpot contributions or potential payouts.
2. Trigger Conditions: The system is configured with predefined rules for jackpot triggers. For example, if a player wins with a three-card hand, the system automatically increases their chance of winning the jackpot or contributes an additional amount to the jackpot pool.
3. Contribution Logic: Each time a triggering event occurs (e.g., a tie), a certain percentage of the player's wager or a fixed contribution is added to the jackpot pool. This creates additional excitement and engagement for players.
4. Progressive Jackpot Accumulation: Over time, the jackpot grows as players encounter these specific events during their baccarat gameplay.

### Example Walk-Through Scenario:

1. Player A is engaged in a baccarat game and places a $100 bet. During the game, the player wins with a three-card combination.
2. The system identifies this three-card win and triggers an additional contribution to the shared jackpot pool, adding excitement and enhancing the player's sense of achievement.
3. Meanwhile, Player B experiences a tie. The system also contributes to the jackpot pool from Player B's bet, further increasing the jackpot's value.
4. As the game progresses, both players have the potential to win the ever-growing jackpot based on future game outcomes.

### Player Interaction:

Players interact with the jackpot system by simply playing baccarat. The system automatically identifies specific triggers (e.g., ties or three-card wins) that affect jackpot contributions or payouts. Players are made aware of these triggers through on-screen prompts or notifications, making the game more engaging by offering unique jackpot-winning opportunities tied to baccarat outcomes.

### Distinguishing Innovative Concepts:

This concept is novel in that it introduces game-specific jackpot triggers for baccarat, a game traditionally played without such features. Conventional baccarat games do not integrate progressive jackpots or triggers based on specific game outcomes, making this approach particularly engaging. Additionally, the integration of these triggers into DETGs offers a dynamic and differentiated gaming experience.

### Distinguishing Inventive Steps:

1. Baccarat-Specific Triggers: The system monitors baccarat-specific events such as ties or three-card wins, which are uncommon in traditional progressive jackpot systems.
2. Automatic Contributions: Trigger events automatically contribute to the jackpot pool, increasing excitement and player engagement.
3. Enhanced Player Incentives: By linking specific baccarat outcomes to jackpot triggers, the system enhances player participation, offering more reasons to engage with the game.

### 35 USC 101 Considerations:

This concept is patentable because it introduces an improvement in game mechanics specifically for baccarat, a traditionally static game. The introduction of dynamic jackpot triggers tied to specific baccarat outcomes represents a technological advancement that enhances both the functionality of the DETG system and the player experience. It integrates into a practical application by directly improving baccarat gameplay through the addition of an engaging, event-driven jackpot system.

### Data Input:

Players input their baccarat bets through the ETGTs. The game results (e.g., tie or three-card win) are processed as inputs to the jackpot system, triggering contributions or payouts.

### Component Interactions and Procedural Steps:

1. Players A and B place their baccarat bets at their respective ETGTs.
2. Player A wins with a three-card hand, and the system identifies this outcome, triggering a contribution to the jackpot pool.
3. Player B experiences a tie, contributing further to the jackpot. The system updates the shared pool in real time.

### Data Processing:

The system processes the baccarat game results, detecting specific outcomes (e.g., ties, three-card wins) and adjusting the jackpot pool accordingly. The progressive jackpot logic is applied to continuously grow the pool based on these events.

### Outputs and Responses:

Players receive real-time feedback on how their game outcomes have contributed to the jackpot pool. Visual and auditory cues may be used to enhance the experience, with notifications for jackpot triggers appearing on the ETGT screens.

### Data Storage and Reporting:

The jackpot server stores data on the specific game events (e.g., number of ties or three-card wins) that contributed to the jackpot. This data may be used for future reporting and analysis.

### Error Handling and Security Measures:

The system verifies the validity of each baccarat trigger event to prevent errors or fraudulent contributions. Security protocols ensure that only legitimate game results are factored into the jackpot calculations.

End of Interaction: After each game, the system updates the jackpot pool based on the baccarat-specific triggers. When the jackpot is won, the system resets and a new round of contributions begins.

### Innovative Concept 84—Casino-Wide Jackpot Contribution Campaigns

### Identification of Concept:

This concept introduces casino-wide jackpot contribution campaigns, where a portion of all DETG bets across the casino network contributes to a single, large mystery jackpot. This approach enhances player engagement by unifying multiple games and players under a common goal of building and potentially winning a substantial jackpot.

By running these campaigns periodically, casinos may generate excitement and drive more participation in DETG games. The campaign may be tied to specific events, holidays, or promotions, creating an additional layer of engagement for both new and returning players.

### Sequence Diagram Components:

The components involved include:
ETGTs: Players at individual terminals contribute to the campaign through their regular gameplay.
Jackpot Server: The server aggregates contributions from all DETG games across the casino network into a unified jackpot pool.
Casino Network: Facilitates the transmission of contribution data from each ETGT to the jackpot server.
Campaign Manager Module: A backend system component that activates the casino-wide campaign, tracks contributions, and controls the campaign's duration.

### Implementation Details:

To implement this concept, the DETG system's infrastructure is expanded to support a casino-wide jackpot pool. Specific steps include:
1. Campaign Activation: The casino activates a campaign where a portion of all DETG bets across various game types contributes to a single, large jackpot pool. This campaign may be linked to specific timeframes or events (e.g., a weekend promotion or holiday celebration).
2. Contribution Logic: Every wager placed on DETGs during the campaign period automatically contributes a small percentage to the shared jackpot. The contribution is identical across all DETGs, ensuring fairness and balance in the pool's growth.
3. Dynamic Jackpot Tracking: Players at any DETG may view the growing jackpot in real time. The jackpot pool is updated dynamically as contributions flow in from games across the casino network.
4. Campaign-Specific Rules: The campaign may include specific rules, such as increased contributions during peak times or additional chances to win during specific game outcomes.

### Example Walk-Through Scenario:

1. The casino announces a weekend-long jackpot campaign, where 2% of all DETG wagers across all games contribute to a massive jackpot.
2. Player A is playing blackjack, Player B is playing baccarat, and Player C is playing roulette. Each player's bet contributes to the shared pool.
3. As the campaign progresses, the jackpot grows exponentially, driving more player participation as they aim for a chance to win the large prize.
4. By the end of the weekend, one lucky player wins the jackpot, and the casino-wide campaign concludes.

### Player Interaction:

Players participate by simply playing their favorite DETG games. Every bet they place during the campaign period contributes to the jackpot, with no additional action required. The unified goal of building a massive jackpot creates a sense of community and competition among players.

### Distinguishing Innovative Concepts:

Casino-wide campaigns are novel because they unify all DETG players under a shared objective, driving participation across multiple game types. Unlike traditional progressive jackpots, which are often limited to a single game, this concept leverages the entire DETG network, making the jackpot larger and more appealing.

### Distinguishing Inventive Steps:

1. Unified Contribution Mechanism: The system aggregates contributions from all DETGs across the casino network, creating a larger, more dynamic jackpot pool.
2. Time-Limited Campaigns: The campaign is only active during specific timeframes or events, adding a layer of excitement and urgency.
3. Cross-Game Participation: Players from different games contribute to the same jackpot, breaking down the barriers between game types and encouraging broader engagement.

### 35 USC 101 Considerations:

This concept is patentable as it introduces a technological improvement in jackpot management across a networked casino environment. By enabling casino-wide campaigns, the system enhances player engagement and increases casino profitability. The ability to unify contributions from multiple games into a single jackpot represents a significant advancement in DETG functionality, solving the problem of fragmented player participation in progressive jackpots.

### Data Input:

Each DETG transmits wager data to the casino network, which aggregates the contributions to the jackpot pool during the campaign period.

### Component Interactions and Procedural Steps:

1. Players A, B, and C place bets at their respective DETGs. The system calculates a percentage of their wagers to contribute to the shared jackpot pool.
2. The campaign manager module tracks contributions from across the casino, dynamically updating the jackpot amount.
3. At the end of the campaign, a winner is determined, and the jackpot is awarded.

### Data Processing:

The system processes contributions in real time, continuously updating the jackpot pool as players place bets during the campaign. The contribution logic ensures fairness across all participating DETGs.

### Outputs and Responses:

Players receive real-time updates on the jackpot's value as it grows throughout the campaign. The campaign manager module also provides notifications when the jackpot is won or when specific milestones are reached.

### Data Storage and Reporting:

The system stores data on campaign contributions and outcomes, allowing the casino to analyze participation trends and player engagement during the campaign.

### Error Handling and Security Measures:

The system verifies all contributions to ensure they are legitimate and accurately counted toward the jackpot pool. Security measures prevent tampering with jackpot calculations.

### End of Interaction:

Once the campaign concludes, the jackpot is awarded, and the system resets for the next campaign or regular jackpot play.

### Innovative Concept 85—Jackpot Re-Roll Feature

### Identification of Concept:

This innovative concept introduces a “Jackpot Re-Roll” feature in DETG (Dealer-controlled Electronic Table Games) systems, where, if a jackpot is not claimed within a certain number of game rounds, the jackpot pool “re-rolls” or increases, enhancing the potential future jackpot value. This mechanic builds player excitement by ensuring that unclaimed jackpots are rolled over into future rounds, creating a progressively larger and more enticing prize pool. This feature may significantly enhance player retention by continuously offering players the possibility of a larger payout, even if no one wins the jackpot in the current session.

In DETG systems, this feature may be applied across various game types, such as blackjack, baccarat, and roulette. The system is designed to track the number of rounds or game cycles since the last jackpot win and automatically increase the prize amount after a predefined threshold is reached without a win.

### Sequence Diagram Components:

The notable components involved include:
ETGTs (Electronic Table Game Terminals): Where players participate in various games, and the system monitors jackpot contribution and re-roll thresholds.
Jackpot Server: The server manages the jackpot pool, monitoring when a jackpot is won and when the re-roll threshold is met, triggering an increase in the jackpot value.
Casino Network: Facilitates communication between all ETGTs and the jackpot server to track the rounds and synchronize jackpot contributions and re-rolls.
Players A, B, C: Participating in the games. They contribute to the jackpot pool and benefit from the re-roll mechanic if no jackpot is won.
Game Logic Processor: Handles jackpot re-roll triggers and recalculates the jackpot after each cycle.

### Implementation Details:

The implementation of this feature involves configuring the jackpot server and the game logic to monitor the number of game rounds completed without a jackpot win. When the predefined threshold is reached, the system automatically increases the jackpot amount based on a predetermined formula or percentage increase.
1. Threshold Setting: The system administrator or casino sets a threshold (e.g., every 50 rounds without a jackpot win). This threshold is embedded into the game logic, ensuring automatic re-rolls once the condition is met.
2. Re-Roll Trigger: After each round of play, the system checks if a jackpot has been won. If no jackpot is claimed, it increments a counter. Once the counter reaches the set threshold, the jackpot re-roll mechanism is activated.
3. Increased Jackpot Value: Upon triggering the re-roll, the system either adds a fixed amount to the jackpot or increases it by a percentage of the current value, making the next potential win more appealing.
4. Player Notification: Players are notified of the re-roll event through on-screen messages or visual indicators, further building excitement and encouraging continued play.

### Example Walk-Through Scenario:

1. Player A is engaged in a blackjack game, Player B in baccarat, and Player C in roulette. All are contributing to the same shared jackpot pool.
2. After 50 game rounds across these DETGs, no player has claimed the jackpot.
3. The system triggers a re-roll event, increasing the jackpot by an additional 10%. Players see the updated jackpot amount displayed on their screens in real-time.
4. The next game round begins with the new, larger jackpot amount, increasing excitement and engagement among players, as the chance to win a larger jackpot is now more enticing.

### Player Interaction:

Players benefit from the re-roll feature through increased jackpot values after a certain number of rounds. This feature does not may require any additional input from the player beyond normal gameplay; the system handles the re-roll process automatically. Players receive visual cues or notifications when a re-roll occurs, which heightens their excitement and motivates them to continue playing for the chance to win the larger jackpot.

### Distinguishing Innovative Concepts:

The re-roll feature distinguishes itself by adding a dynamic jackpot growth mechanism that guarantees an increase in the potential jackpot if it is not claimed within a predefined time or number of game rounds. Unlike conventional progressive jackpots that simply grow with contributions, the re-roll feature ensures consistent growth even during periods of lower jackpot win activity. This mechanic adds a sense of anticipation and motivates players to keep playing, knowing that the jackpot will eventually increase, making it a notable differentiator from prior art.

### Distinguishing Inventive Steps:

1. Re-Roll Threshold Tracking: The system continuously tracks the number of game rounds without a jackpot win, ensuring that the re-roll occurs once the threshold is reached.
2. Automatic Jackpot Increase: Upon reaching the threshold, the jackpot is increased automatically, either by a fixed amount or a percentage, without requiring any manual intervention.
3. Player Notification System: Players are immediately informed when a re-roll occurs, enhancing their anticipation and engagement by making them aware of the larger jackpot.

### 35 USC 101 Considerations:

This concept is patentable because it introduces a new method for dynamically adjusting jackpot values in DETG systems based on game activity. The re-roll mechanism goes beyond an abstract idea by solving a practical problem-how to maintain player interest during periods of low jackpot win activity. This system improves the functionality of electronic jackpot management by automatically increasing jackpot values after a predefined number of rounds, enhancing both player engagement and casino revenue. The feature integrates seamlessly into existing DETG platforms, offering a practical improvement to gaming system operations.

### Data Input:

The data inputs include the number of rounds played since the last jackpot win and the contributions from each player to the jackpot pool. The system monitors these inputs to determine when the re-roll threshold is met and adjusts the jackpot accordingly.

### Component Interactions and Procedural Steps:

1. Players A, B, and C place their bets at the respective DETGs.
2. The system tracks the number of game rounds without a jackpot win, incrementing the counter after each round.
3. When the re-roll threshold is reached, the system automatically increases the jackpot and updates the display across all terminals.

### Data Processing:

The system processes the number of rounds since the last jackpot win and applies the re-roll logic when the threshold is met. The jackpot value is recalculated based on a predefined formula or percentage increase.

### Outputs and Responses:

Players receive real-time feedback on the re-roll event through visual and auditory cues on their DETGs, informing them that the jackpot has increased. This notification encourages continued play as players now have a chance to win a larger jackpot.

### Data Storage and Reporting:

The system stores data on the number of rounds played between each jackpot win and re-roll event. This information may be used for future analysis to optimize re-roll thresholds and maximize player engagement.

### Error Handling and Security Measures:

The system ensures accurate tracking of game rounds and jackpot increases, with error-checking protocols in place to verify that the correct jackpot values are displayed. Security measures prevent tampering with the re-roll logic or jackpot value.

### End of Interaction:

Once the re-roll occurs, the game continues with the new, larger jackpot. The system resets the round counter and begins tracking again until the next re-roll threshold is met.

### Innovative Concept 86—Progressive Jackpot Capping Mechanism

### Identification of Concept:

This innovative concept introduces a “Progressive Jackpot Capping Mechanism” in DETG systems, where a cap is applied to prevent the mystery jackpot from exceeding a certain predefined limit. Once the jackpot reaches this cap, any excess funds are diverted into future jackpot pools or used for secondary prizes. This capping mechanism ensures that jackpots do not grow indefinitely, maintaining control over prize amounts and enabling casinos to offer more structured and predictable payouts.

The cap helps avoid extreme jackpot sizes that may reduce player engagement due to the low probability of winning a massive prize. Instead, by capping the jackpot and rolling excess contributions into subsequent jackpots or secondary prizes, casinos may maintain excitement and offer players more frequent winning opportunities.

### Sequence Diagram Components:

The components involved include:
ETGTs: Players contribute to the jackpot through their regular bets. The system monitors the cumulative jackpot value across all terminals.
Jackpot Server: The server tracks contributions to the jackpot pool and enforces the cap, redirecting excess funds once the cap is reached.
Casino Network: Facilitates communication between the ETGTs and the jackpot server, ensuring real-time tracking of jackpot growth.
Players A, B, C: Participants contributing to the jackpot. They benefit from both the main jackpot and the secondary prize pools generated by the capping mechanism.
Cap Management System: A subsystem that monitors the jackpot size and automatically diverts excess contributions once the cap is reached.

### Implementation Details:

To implement the progressive jackpot cap, the casino's DETG system is configured with a capping threshold, which may be set at the discretion of the casino operator. Once the jackpot reaches this threshold, the system automatically redirects excess contributions into a new jackpot pool or uses them to fund secondary prizes. Specific steps include:
1. Cap Configuration: The jackpot cap is set by the casino (e.g., $1 million). Once this value is reached, the cap management system becomes active.
2. Redirection of Excess Contributions: When the jackpot reaches the cap, any additional contributions from players are redirected into a secondary pool, which may be used for a new jackpot or distributed as smaller prizes.
3. Player Communication: Players are informed via their ETGTs when the jackpot has been capped. This ensures transparency and informs them of the additional prizes or new jackpot pool being created.

### Example Walk-Through Scenario:

1. The progressive jackpot in a casino grows over time as players place bets on various DETGs, eventually reaching the $1 million cap.
2. Once the cap is reached, the cap management system activates, and any further contributions are redirected into a new secondary jackpot pool.
3. Players are notified that the main jackpot has been capped and that they now have a chance to win either the main jackpot or one of the secondary jackpots generated by the excess contributions.

### Player Interaction:

Players interact with the capped jackpot system automatically as they continue placing bets. Once the jackpot reaches the cap, they are notified of the cap and the availability of secondary prizes. The system allows them to win the capped jackpot or potentially win one of the secondary prizes funded by the excess contributions.

### Distinguishing Innovative Concepts:

This concept distinguishes itself by introducing a mechanism for managing runaway jackpot growth. By capping the jackpot, the system ensures that prize amounts remain enticing but realistic, improving player engagement. Additionally, the use of excess funds to create secondary prize pools offers more frequent win opportunities, making the gaming experience more dynamic.

### Distinguishing Inventive Steps:

1. Cap Enforcement: The system automatically enforces a cap on the jackpot, preventing it from exceeding a predefined limit.
2. Excess Contribution Redirection: Once the cap is reached, any additional contributions are redirected to new jackpots or secondary prizes, enhancing the overall prize structure.
3. Player Notification: Players are informed in real-time when the cap is reached, ensuring transparency and encouraging participation in the secondary prize pools.

### 35 USC 101 Considerations:

This concept is patentable because it addresses a practical problem in progressive jackpot management by introducing a cap to control jackpot growth. The redirection of excess funds into secondary prize pools adds value by creating more winning opportunities for players. This system enhances the functionality of DETG jackpot management, providing a more structured and engaging prize system, thus improving both casino operations and player experience.

### Data Input:

Player bets are tracked in real time, contributing to the progressive jackpot. Once the jackpot reaches the cap, additional contributions are directed into secondary pools.

### Component Interactions and Procedural Steps:

1. Players A, B, and C continue placing bets at their DETGs, contributing to the shared jackpot.
2. The system tracks the jackpot value and enforces the cap when the predefined threshold is reached.
3. Excess contributions are redirected into secondary prize pools, and players are notified of the capped jackpot.

### Data Processing:

The system processes player contributions, calculates when the jackpot reaches the cap, and diverts additional contributions into secondary prize pools. This ensures smooth operation and transparent prize distribution.

### Outputs and Responses:

Once the cap is reached, the system notifies players of the capped jackpot and the availability of secondary prizes. The jackpot pool is reset for future contributions, while secondary prizes are distributed or pooled for later use.

### Data Storage and Reporting:

The system stores data on the jackpot cap, player contributions, and the distribution of secondary prizes. This data may be used for reporting and future optimization of jackpot management.

### Error Handling and Security Measures:

The system includes safeguards to prevent contributions from exceeding the cap or being misdirected. Security protocols ensure that all jackpot and prize data is accurate and tamper-proof.

### End of Interaction:

Once the jackpot is capped and secondary prize pools are established, the system resets the main jackpot for future contributions. Players continue participating in both the main and secondary prize pools.

### Innovative Concept 87—Jackpot Prediction System for Players

### Identification of Concept:

This innovative concept introduces a “Jackpot Prediction System” for players, where the system provides predictions or probabilities of when the mystery jackpot may trigger based on historical data, player behavior, and past outcomes. This feature uses statistical analysis and machine learning algorithms to generate insights into potential jackpot triggers, enhancing player engagement by offering them a sense of increased control or foresight.

In DETG (Dealer-controlled Electronic Table Games) systems, the prediction system may be integrated across multiple game types, providing players with probability-based indicators displayed on their Electronic Table Game Terminals (ETGTs). While the prediction does not guarantee a win, it adds an extra layer of excitement, making the gameplay experience more interactive and personalized.

### Sequence Diagram Components:

The notable components involved in this system include:
ETGTs: Display predictions to players during gameplay based on the prediction system's calculations.
Prediction Engine: A dedicated server or module that uses data from past gameplay (e.g., number of rounds, jackpot triggers) to generate probability estimates.
Player A and Player B: Players at the terminals receiving prediction information.
Casino Network: Facilitates data collection and communication between the ETGTs and the prediction engine, allowing real-time updates based on ongoing gameplay.
Game Data Analyzer: A system component that collects historical data from all relevant game sessions and processes this information using machine learning models or statistical analysis techniques.

### Implementation Details:

The implementation of the Jackpot Prediction System involves a combination of data analysis tools and predictive algorithms. The system analyzes historical gameplay data from DETGs to detect patterns and generate predictions.
1. Data Collection: The system continuously collects gameplay data, including jackpot triggers, game outcomes, player behavior, betting patterns, and timing of wins.
2. Predictive Analysis: The prediction engine applies machine learning algorithms or statistical models to analyze this data, generating probability estimates of when a jackpot may be triggered. This may be based on parameters such as the number of game rounds played without a win, average bet sizes, and other relevant factors.
3. Player Display: The prediction system displays real-time probability estimates on the ETGTs. Players may view these probabilities as they play, adding a new layer of strategy to their decisions.
4. Adaptive Predictions: The system updates the predictions dynamically based on the real-time progression of the game. This ensures that the probabilities remain relevant and up-to-date throughout the gameplay session.

### Example Walk-Through Scenario:

1. Player A is engaged in a baccarat game, and after several rounds of play, the prediction engine calculates that the probability of a jackpot trigger is increasing based on the number of rounds without a win.
2. The system displays a notification on Player A's ETGT, showing that there is a 30% probability of a jackpot being triggered in the next 10 rounds.
3. Meanwhile, Player B is playing blackjack and receives a similar prediction that the likelihood of a jackpot trigger is higher if certain bet patterns are followed, based on historical data.
4. Both players use this information to adjust their gameplay strategies, placing higher or more frequent bets in anticipation of the jackpot.

### Player Interaction:

Players interact with the prediction system passively by viewing the probability data presented on their ETGTs. The predictions may influence their betting decisions, adding a new strategic element to the game. While the predictions do not guarantee a win, they heighten the player's engagement and encourage more active participation, especially when the probability of a jackpot trigger is perceived to be increasing.

### Distinguishing Innovative Concepts:

The jackpot prediction system is distinct from prior art because it uses advanced data analytics and machine learning algorithms to provide real-time probability estimates to players. This feature gives players a perceived edge by offering data-driven insights into the likelihood of a jackpot win. Conventional systems do not provide such predictive information, making this concept novel and more interactive.

### Distinguishing Inventive Steps:

1. Predictive Algorithm Integration: The system uses advanced statistical models and machine learning algorithms to analyze gameplay data and generate real-time predictions.
2. Dynamic Updates: Predictions are continuously updated based on real-time gameplay, ensuring relevance and engagement for players.
3. Data-Driven Player Interaction: Players receive probability estimates that may influence their decisions and gameplay strategies, adding a layer of personalization that is absent in traditional jackpot systems.

### 35 USC 101 Considerations:

This innovative concept is patentable under 35 USC 101 as it improves the functionality of DETG systems by introducing a data-driven predictive mechanism. The prediction system offers an improvement over traditional jackpot systems by leveraging historical data and real-time analysis to provide actionable insights to players. This system integrates into a practical application by enhancing player engagement and creating a more interactive gameplay experience, which represents a tangible improvement in the way DETG systems operate.

### Data Input:

The system collects data from previous game sessions, including the timing of jackpot triggers, betting patterns, game outcomes, and player behaviors. This data is used to train predictive models and generate real-time probability estimates.

### Component Interactions and Procedural Steps:

1. Player A places a bet on the baccarat game, and the system updates the probability of a jackpot trigger based on real-time gameplay data.
2. The prediction engine analyzes the data from multiple players across different DETGs, continuously recalculating the probabilities.
3. Players A and B receive updated probability estimates on their ETGT screens, influencing their betting strategies.

### Data Processing:

The prediction engine processes the historical and real-time data using machine learning algorithms, calculating probabilities based on various factors such as time since the last jackpot, betting patterns, and game outcomes. The predictions are displayed to players in real-time.

### Outputs and Responses:

The system outputs real-time probability estimates to players, indicating the likelihood of a jackpot trigger. Players receive visual or auditory cues when the probability reaches significant thresholds.

### Data Storage and Reporting:

The system stores data on past game outcomes, player behavior, and betting patterns for use in predictive analysis. This data is continuously updated and may be used for further refinement of the predictive models.

### Error Handling and Security Measures:

The system includes safeguards to ensure accurate data collection and analysis, preventing erroneous predictions. Security protocols protect the integrity of the historical data and the machine learning models used for predictions.

### End of Interaction:

After each game session, the system resets the prediction models and continues collecting data for future predictions. Players may view updated probability estimates in future games, ensuring ongoing engagement with the prediction system.

### Innovative Concept 88—Simultaneous Multi-Game Jackpot Linking

### Identification of Concept:

This innovative concept introduces a “Simultaneous Multi-Game Jackpot Linking” system, allowing multiple DETGs (Dealer-controlled Electronic Table Games) running different game types (e.g., blackjack, baccarat, and roulette) to be linked to a single, shared jackpot pool. Unlike traditional systems where jackpots are game-specific, this system enables players across different games to contribute to and potentially win the same jackpot, fostering cross-game excitement and competition.

The simultaneous linking creates a larger, more dynamic jackpot pool as players from multiple game types are contributing, thus accelerating the jackpot's growth. This also provides players with more opportunities to participate in jackpot events, regardless of their preferred game.

### Sequence Diagram Components:

The components involved include:
ETGTs: Players across different DETGs are contributing to the shared jackpot. Each terminal tracks contributions and jackpot triggers.
Jackpot Server: The centralized server aggregates contributions from all participating games and determines when the jackpot is won.
Casino Network: Ensures seamless communication between ETGTs and the jackpot server, facilitating real-time updates to the jackpot pool.
Players A, B, C: Participating in different games (e.g., Player A is playing blackjack, Player B is playing baccarat, and Player C is playing roulette), all contributing to the same jackpot pool.
Game Logic Processor: Manages the contribution mechanism, jackpot eligibility, and triggers across all linked game types.

### Implementation Details:

To implement this system, the casino configures multiple game types on the DETG platform to contribute to a shared jackpot pool. Specific steps include:
1. Game Type Integration: The system is configured to support contributions from multiple game types, ensuring that blackjack, baccarat, roulette, and other games may all contribute to the same jackpot pool.
2. Contribution Mechanism: A portion of each player's wager, regardless of game type, is contributed to the shared jackpot pool. The contribution logic is consistent across all games, ensuring fairness and uniformity.
3. Jackpot Triggering: The system monitors game outcomes across different games. Any player in any game has a chance to trigger the jackpot based on predefined criteria (e.g., achieving a specific hand in blackjack or a win streak in baccarat).
4. Cross-Game Updates: The jackpot pool is updated in real time across all ETGTs. Players in different games may see the growing jackpot, fostering a sense of shared excitement.

### Example Walk-Through Scenario:

1. Player A is playing blackjack and contributes $1 to the shared jackpot pool with each wager. Meanwhile, Player B playing baccarat and Player C playing roulette are also contributing to the same pool.
2. The jackpot pool grows as each player places their bets, regardless of the game they are playing.
3. Player B wins a baccarat hand that meets the jackpot trigger criteria, winning the shared jackpot. The jackpot server updates the pool in real-time, and all players are notified of the win.

### Player Interaction:

Players contribute to and monitor the same jackpot pool, regardless of which game they are playing. This creates a sense of unity and competition across different games, as players in various games are all working toward the same prize. Players may follow the progress of the jackpot in real-time on their ETGTs, increasing engagement.

### Distinguishing Innovative Concepts:

This system differs from traditional jackpot systems by linking multiple game types to a single jackpot pool. The simultaneous contribution mechanism and the potential for any player, in any game, to trigger the jackpot are notable differentiators. This fosters cross-game interaction and competition, making the system more dynamic and engaging than conventional, game-specific jackpots.

### Distinguishing Inventive Steps:

1. Multi-Game Contribution Mechanism: Players from different game types contribute to the same jackpot, creating a larger and faster-growing prize pool.
2. Cross-Game Jackpot Triggering: Players from any game type have the chance to win the shared jackpot based on the outcomes of their specific game.
3. Real-Time Cross-Game Updates: The system provides real-time updates to all participating ETGTs, ensuring that players are aware of jackpot growth and wins across games.

### 35 USC 101 Considerations:

This innovative concept is patentable under 35 USC 101 because it introduces a new method for linking multiple game types to a single jackpot pool, which improves the overall functionality of DETG systems. By allowing simultaneous multi-game contributions, the system fosters increased player engagement and creates a more dynamic gaming experience. This system integrates into a practical application by enhancing the operation of jackpot management across various DETG platforms, offering a significant improvement over traditional game-specific jackpot systems.

### Data Input:

Player bets across different game types are tracked and contributed to the shared jackpot pool. The system monitors game outcomes to determine when the jackpot is triggered.

### Component Interactions and Procedural Steps:

1. Players A, B, and C place bets in their respective games (blackjack, baccarat, roulette), contributing to the shared jackpot pool.
2. The jackpot server aggregates contributions and updates the jackpot value in real-time across all ETGTs.
3. The system monitors game outcomes to determine if the jackpot trigger conditions are met.

### Data Processing:

The system processes contributions from multiple game types and recalculates the jackpot pool in real-time. It also tracks player actions and game outcomes to determine when the jackpot is triggered.

### Outputs and Responses:

All players are notified when the jackpot is won, regardless of the game they are playing. The jackpot pool is reset after a win, and a new round of contributions begins.

### Data Storage and Reporting:

The system stores data on player contributions, jackpot wins, and the amount of funds redirected to the shared pool. This data may be used for reporting and optimizing jackpot configurations.

### Error Handling and Security Measures:

The system includes protocols to ensure accurate contribution tracking across all game types. Security measures protect the integrity of the jackpot pool and prevent tampering with the contribution and win mechanisms.

### End of Interaction:

Once the jackpot is won, the system resets the pool and continues collecting contributions from all games. Players are encouraged to keep participating in any game, knowing they have a chance to win the shared jackpot.

### Innovative Concept 89—Personalized Jackpot Tiers

### Identification of Concept:

This innovative concept introduces “Personalized Jackpot Tiers” in DETG systems, allowing players to participate in different jackpot tiers based on their betting behavior, history, and personal preferences. Rather than having a single jackpot pool for all players, the system offers multiple jackpot tiers, each with varying prize amounts and probability of winning. This approach personalizes the jackpot experience by allowing players to choose a tier that aligns with their risk appetite and betting strategy.

Players may opt to contribute to a low-tier jackpot with smaller but more frequent payouts, or a high-tier jackpot with larger but less frequent payouts. This tiered system caters to different player types, enhancing the gaming experience by providing tailored jackpot options.

### Sequence Diagram Components:

Notable components involved include:
ETGTs: Players may choose their preferred jackpot tier when placing bets. Each terminal tracks the player's contributions and tier selection.
Jackpot Server: Manages multiple jackpot tiers, tracking contributions to each and determining winners based on tier-specific conditions.
Casino Network: Facilitates communication between the ETGTs and the jackpot server, ensuring that player contributions are directed to the appropriate tier.
Player A and Player B: Players may opt for different jackpot tiers based on their betting preferences.
Tier Management System: A subsystem that handles the creation and management of multiple jackpot tiers, including prize amounts, contribution rates, and win probabilities.

### Implementation Details:

To implement personalized jackpot tiers, the DETG system is configured to offer multiple jackpot options to players. Specific steps include:
1. Tier Selection: When placing a bet, players may choose their preferred jackpot tier from a list of available options. Each tier has a different contribution rate, prize amount, and probability of winning.
2. Tier-Specific Contributions: A portion of the player's bet is directed to the selected jackpot tier, with the contribution percentage and prize pool varying by tier.
3. Dynamic Updates: The system updates the jackpot pools for each tier in real-time, ensuring transparency and excitement for players in all tiers.

### Example Walk-Through Scenario:

1. Player A prefers high-risk, high-reward gameplay and chooses the high-tier jackpot, contributing $5 from their bet to the pool. Meanwhile, Player B opts for the low-tier jackpot, contributing $1 for more frequent, smaller payouts.
2. Both players place their bets in their respective games (e.g., blackjack and baccarat), and the system directs their contributions to the appropriate jackpot pools.
3. As the game progresses, both the high-tier and low-tier jackpot pools grow, and players in each tier have a chance to win their respective jackpots.

### Player Interaction:

Players interact with the jackpot system by selecting their preferred tier before placing bets. The tiered structure gives players more control over their gameplay experience, allowing them to choose a risk-reward balance that aligns with their personal preferences. This personalization enhances engagement by offering tailored jackpot experiences.

### Distinguishing Innovative Concepts:

This system differentiates itself from conventional jackpot systems by offering personalized tiers. Unlike traditional single-pool jackpots, this system provides players with multiple options, each with its own risk-reward structure. The tiered approach appeals to a broader range of players, from casual gainers seeking frequent wins to high rollers aiming for larger payouts.

### Distinguishing Inventive Steps:

1. Personalized Jackpot Tiers: Players may select from multiple jackpot tiers based on their preferences, tailoring their gaming experience.
2. Dynamic Tier-Specific Contributions: The system tracks contributions and prize pools for each tier in real-time, ensuring fairness and transparency.
3. Tiered Jackpot Win Probabilities: Each tier has different winning probabilities, allowing players to choose between more frequent smaller wins or less frequent larger wins.

### 35 USC 101 Considerations:

This innovative concept is patentable under 35 USC 101 as it introduces a novel method for personalizing jackpot systems based on player behavior and preferences. By offering multiple tiers with varying prize amounts and win probabilities, the system enhances the functionality of DETG platforms and provides a tailored gaming experience. This system integrates into a practical application by offering a flexible and engaging jackpot structure that appeals to a wide range of player types.

### Data Input:

Players input their tier selection when placing bets. This data is used to direct their contributions to the appropriate jackpot pool.

### Component Interactions and Procedural Steps:

1. Players A and B select their jackpot tiers when placing bets, with Player A choosing the high-tier jackpot and Player B selecting the low-tier jackpot.
2. The system directs contributions from both players to the appropriate jackpot pools.
3. The jackpot server tracks each tier's contributions and updates the prize pools in real-time.

### Data Processing:

The system processes player contributions and updates each jackpot tier's prize pool accordingly. The tier management system ensures that each player's contributions are directed to the correct pool based on their selection.

### Outputs and Responses:

Players receive real-time updates on the growth of their selected jackpot tier. When a jackpot is won, the system notifies all players in that tier and resets the pool for future contributions.

### Data Storage and Reporting:

The system stores data on player tier selections, contributions, and jackpot wins for each tier. This data is used for reporting and analysis, allowing casinos to optimize their tiered jackpot offerings.

### Error Handling and Security Measures:

The system ensures that contributions are accurately tracked and directed to the correct jackpot tier. Security protocols protect the integrity of the tier management system and prevent tampering.

### End of Interaction:

After each game session, the system resets the jackpot pools for each tier. Players may continue selecting their preferred tier in future sessions, allowing for ongoing engagement with the personalized jackpot system.

### Innovative Concept 90—Side Bet Contribution Multiplier for Jackpots

### Identification of Concept:

This innovative concept introduces a Side Bet Contribution Multiplier for jackpots in DETG (Dealer-controlled Electronic Table Games) systems. The multiplier feature allows players to increase their chances of winning a mystery jackpot by placing additional side bets that offer enhanced contributions to the jackpot pool. By increasing the size or frequency of side bets, players may multiply their contributions to the jackpot pool and, in some cases, their likelihood of triggering the jackpot itself. This feature is designed to appeal to high-stakes players or those looking for a greater level of engagement by offering a way to directly influence their jackpot potential.

In this system, side bets are not just contributions but come with a multiplier option, meaning a player's contribution may be multiplied based on their wager. This creates a dynamic and customizable betting experience, where the size of the player's side bet influences their potential reward.

### Sequence Diagram Components:

The components involved include:
ETGTs: Players place side bets through the Electronic Table Game Terminals, where they may select a multiplier to increase their jackpot contribution.
Jackpot Server: Manages contributions to the jackpot pool and applies the multiplier effect based on each player's side bet.
Casino Network: Communicates side bet contributions and multiplier information from each ETGT to the jackpot server in real time.
Player A and Player B: Players choose whether to apply a multiplier to their side bets. Player A may opt for a higher multiplier, while Player B may choose a standard contribution.
Game Logic Processor: Calculates the multiplier effect based on the size of the player's side bet and updates the jackpot pool accordingly.

### Implementation Details:

To implement this feature, the DETG system integrates an option on each ETGT that allows players to apply multipliers to their side bets. Specific implementation steps include:
1. Side Bet Configuration: When placing a side bet, players are presented with the option to apply a multiplier (e.g., 2×, 5×, or 10×) to increase their jackpot contribution.
2. Contribution Scaling: The jackpot server processes the side bet and applies the chosen multiplier. For example, if a player selects a 5× multiplier on a $10 side bet, $50 is added to the jackpot pool.
3. Multiplier Limits: The system may set limits on the multiplier options, ensuring that the jackpot pool grows at a sustainable rate. For instance, the multiplier may be capped at 10×.
4. Real-Time Updates: The system updates the jackpot pool in real time as players place side bets with multipliers, and all players may see the growing jackpot value on their ETGT screens.

### Example Walk-Through Scenario:

1. Player A sits at a blackjack ETGT and places a $20 side bet with a 5× multiplier. This results in a $100 contribution to the shared jackpot pool.
2. Player B at the same table places a $10 side bet without applying a multiplier, contributing $10 to the jackpot pool.
3. The jackpot server processes both side bets and updates the pool accordingly, with Player A's contribution being significantly higher due to the multiplier.
4. Both players are eligible for the jackpot, but Player A has a greater chance of winning due to their larger contribution.

### Player Interaction:

Players may interact with the side bet multiplier option through the ETGT's interface, selecting how much they want to multiply their contributions to the jackpot pool. This feature gives players more control over their risk and reward strategy, allowing them to influence their likelihood of winning the jackpot. For high-stakes players, the multiplier feature adds an additional layer of excitement and engagement, as they may significantly boost their contributions.

### Distinguishing Innovative Concepts:

This concept introduces a dynamic contribution mechanism that allows players to amplify their engagement with the jackpot pool through side bet multipliers. Unlike traditional side bets, which have a fixed contribution, this system lets players customize their contributions based on their betting preferences. The multiplier option differentiates this concept from conventional jackpot systems by offering players a direct way to enhance their odds.

### Distinguishing Inventive Steps:

1. Multiplier-Based Contributions: Players may multiply their jackpot contributions by selecting side bet multipliers, adding a strategic layer to their wagering.
2. Customizable Betting Strategy: This system allows players to tailor their contributions to the jackpot pool, based on their risk tolerance and reward expectations.
3. Real-Time Jackpot Updates: The jackpot pool dynamically adjusts based on player contributions and multipliers, ensuring transparency and excitement.

### 35 USC 101 Considerations:

This innovative concept is patentable under 35 USC 101 because it introduces a specific, non-abstract improvement in jackpot contribution systems for DETGs. By allowing players to customize their side bet contributions through multipliers, the system enhances the functionality of electronic gaming systems, creating a more engaging and interactive player experience. This system offers a tangible improvement in the way jackpot pools are managed and how players may influence their potential winnings.

### Data Input:

Players input their side bets and choose whether to apply a multiplier. This data is transmitted to the jackpot server, which processes the contributions and updates the pool accordingly.

### Component Interactions and Procedural Steps:

1. Player A and Player B place their side bets, with Player A opting for a multiplier and Player B selecting the standard contribution.
2. The jackpot server processes the side bet contributions, applying the multiplier to Player A's contribution and updating the jackpot pool in real time.
3. Players are notified of the updated jackpot value and their chances of winning based on their contributions.

### Data Processing:

The system calculates the side bet contributions and applies the chosen multipliers. The jackpot pool is updated dynamically, and the server tracks the total contributions for each player.

### Outputs and Responses:

Players receive real-time updates on the jackpot pool and their contribution status. The system also notifies players of their increased chances of winning based on their multiplied contributions.

### Data Storage and Reporting:

The system stores data on player contributions, multiplier selections, and jackpot pool updates. This data may be used for reporting and analysis, allowing casinos to monitor the effectiveness of the multiplier system.

### Error Handling and Security Measures:

The system includes error-checking mechanisms to ensure that multipliers are applied correctly and that jackpot contributions are accurately tracked. Security measures prevent tampering with the multiplier settings or contribution data.

### End of Interaction:

After each game session, the system resets side bet contributions and multiplier options for the next round. Players may continue using the multiplier feature in future sessions to influence their jackpot contributions.

### Innovative Concept 91—Jackpot Accumulation Across Multiple Casino Locations

### Identification of Concept:

This innovative concept introduces Jackpot Accumulation Across Multiple Casino Locations for DETG systems. The concept involves linking multiple physical casinos or gaming venues into a single jackpot network, allowing players at different locations to contribute to and win from the same shared jackpot pool. This cross-location linkage creates significantly larger jackpots, increasing excitement and participation as players across various venues work together to build the pool.

This concept enables casinos within a network (e.g., across a city, region, or even globally) to contribute to a centralized jackpot system, creating opportunities for massive jackpot prizes. It enhances the DETG experience by broadening the player base contributing to the pool and making the prize much larger than it would be in a single-location environment.

### Sequence Diagram Components:

The components involved include:
ETGTs: Players at various casino locations use Electronic Table Game Terminals to place bets, all contributing to the shared jackpot pool.
Centralized Jackpot Server: A server located on a casino network that aggregates contributions from multiple locations into a single, shared jackpot pool.
Casino Network: Links multiple casino locations together, transmitting jackpot contributions and updates between different venues in real time.
Players A, B, and C: Players at different casino locations (e.g., Player A at Casino 1, Player B at Casino 2, and Player C at Casino 3), all contributing to the same jackpot.
Game Logic Processor: Manages contributions from each casino location and updates the jackpot pool across all participating venues.

### Implementation Details:

To implement this system, multiple casino locations are linked via a centralized jackpot server that aggregates contributions from all participating DETGs. Specific steps include:
1. Inter-Casino Network Configuration: The casino network is set up to link ETGTs from different locations, allowing players from each casino to contribute to the same jackpot.
2. Centralized Jackpot Pool: All contributions from participating casino locations are aggregated into a single pool managed by the centralized jackpot server.
3. Real-Time Synchronization: The system synchronizes jackpot contributions and updates across all locations, ensuring that the growing jackpot value is displayed in real-time at every participating venue.
4. Jackpot Triggers: Players at any location may trigger the jackpot based on predefined conditions. When the jackpot is won, the system resets and begins accumulating contributions for the next round.

### Example Walk-Through Scenario:

1. Player A is playing blackjack at Casino 1, contributing to a shared jackpot pool. Player B at Casino 2 is playing baccarat, and Player C at Casino 3 is playing roulette. All three players are contributing to the same jackpot.
2. The centralized jackpot server aggregates contributions from all three casinos, updating the jackpot pool in real time.
3. Player B wins the jackpot at Casino 2, and players at all other participating casinos are notified of the win.
4. The jackpot pool resets across all locations, and a new round of contributions begins.

### Player Interaction:

Players interact with the jackpot system through their local ETGTs, but the excitement is amplified because they know that players across multiple locations are contributing to the same pool. The possibility of winning a much larger jackpot keeps players engaged, as the combined contributions from multiple venues lead to larger prizes.

### Distinguishing Innovative Concepts:

This concept is novel because it links multiple casino locations to a single jackpot pool, creating larger and more enticing prizes. Unlike conventional progressive jackpots that are restricted to a single location, this system extends the player base and prize potential by aggregating contributions from a network of casinos. The cross-location linkage also enhances the social aspect of jackpot gaming, as players from different venues are all participating in the same game.

### Distinguishing Inventive Steps:

1. Cross-Location Contribution Mechanism: Players at different casino locations contribute to the same jackpot, creating a much larger prize pool than would be possible at a single venue.
2. Centralized Jackpot Server: A centralized server manages contributions from all participating locations, synchronizing the jackpot pool in real-time.
3. Inter-Casino Communication: The system ensures seamless communication between different casino locations, enabling real-time updates and jackpot triggers across the entire network.

### 35 USC 101 Considerations:

This concept is patentable under 35 USC 101 because it introduces a new method of linking multiple casino locations to a single jackpot pool, which improves the functionality of DETG systems. By enabling inter-casino communication and centralized jackpot management, the system offers a tangible improvement over traditional location-specific jackpots. This system enhances player engagement and casino profitability by creating much larger and more dynamic jackpot opportunities.

### Data Input:

Player contributions are tracked at each casino location and transmitted to the centralized jackpot server. The system also monitors game outcomes to determine when the jackpot is triggered.

### Component Interactions and Procedural Steps:

1. Players A, B, and C place bets at their respective casino locations, contributing to the shared jackpot pool.
2. The centralized jackpot server aggregates contributions from all participating casinos and updates the pool in real-time across all ETGTs.
3. When the jackpot is won, the system resets the pool and notifies all participating locations.

### Data Processing:

The centralized jackpot server processes contributions from all casino locations, calculating the total jackpot value and updating the pool in real-time. The server also monitors game outcomes to determine when the jackpot is triggered.

### Outputs and Responses:

The jackpot pool is updated in real-time across all participating casinos, ensuring that players are aware of the growing prize. When a jackpot is won, the system resets the pool and begins accumulating contributions for the next round.

### Data Storage and Reporting:

The system stores data on player contributions, jackpot triggers, and winnings across all participating casino locations. This data may be used for reporting and analysis, allowing casinos to monitor the effectiveness of the cross-location jackpot system.

### Error Handling and Security Measures:

The system includes safeguards to ensure accurate tracking of contributions across all casino locations. Security protocols prevent tampering with jackpot data or cross-location communication.

### End of Interaction:

Once the jackpot is won, the system resets the pool and begins collecting contributions for the next jackpot across all casino locations. Players at any participating venue may continue contributing to and competing for the shared prize.

### Innovative Concept 92—Player Jackpot Insurance

### Identification of Concept:

This innovative concept introduces Player Jackpot Insurance in DETG systems, where players may purchase insurance against missing out on a jackpot win. In this system, players who do not place the necessary side bets to qualify for a jackpot may still receive a smaller consolation payout if they meet the jackpot trigger conditions but had not contributed to the jackpot pool. This insurance feature provides a safety net for players, ensuring that they are not entirely excluded from jackpot rewards even if they choose not to participate in the jackpot side bet.

The insurance mechanism allows players to hedge their bets and still receive a portion of the jackpot or a consolation prize, adding an extra layer of engagement and decision-making to the gaming experience.

### Sequence Diagram Components:

The components involved include:
ETGTs: Players may opt to purchase jackpot insurance through their Electronic Table Game Terminals, covering their gameplay session.
Jackpot Insurance Server: A dedicated server that tracks players who have purchased insurance and calculates payouts when they meet jackpot conditions without having contributed to the jackpot pool.
Casino Network: Manages communication between ETGTs and the insurance server, tracking player bets, game outcomes, and insurance purchases. Player A and Player B: Player A chooses not to contribute to the jackpot pool but purchases insurance, while Player B contributes to the jackpot without purchasing insurance.
Game Logic Processor: Tracks game outcomes and determines whether players are eligible for a jackpot payout or a consolation prize through insurance.

### Implementation Details:

To implement the Player Jackpot Insurance system, the ETGTs are equipped with an insurance option that players may select during gameplay. Specific steps include:
1. Insurance Purchase: Players are given the option to purchase jackpot insurance when placing their initial bet. The insurance covers the player for a fixed number of game rounds.
2. Consolation Payout Mechanism: If a player who has purchased insurance meets the conditions to trigger the jackpot but has not contributed to the jackpot pool, they are eligible for a smaller consolation payout.
3. Insurance Server Management: The jackpot insurance server tracks which players have purchased insurance and calculates the payout amounts based on the game outcomes.

### Example Walk-Through Scenario:

1. Player A is playing baccarat and chooses not to contribute to the jackpot pool but opts to purchase jackpot insurance for $5.
2. During the game, Player A wins a hand that would have triggered the jackpot if they had contributed. Since they purchased insurance, they receive a consolation prize of $500 instead of the full jackpot.
3. Player B at the same table contributed to the jackpot and wins the full amount of $10,000 when they meet the jackpot trigger conditions.

### Player Interaction:

Players interact with the jackpot insurance system by choosing whether or not to purchase insurance during gameplay. This feature adds an additional layer of strategy, as players may decide whether they want to hedge their bets and still have a chance at winning something, even if they choose not to participate in the jackpot pool.

### Distinguishing Innovative Concepts:

This concept is novel because it provides players with a safety net in the form of jackpot insurance, which is not commonly available in traditional jackpot systems. By offering players the ability to purchase insurance, the system encourages more strategic gameplay and ensures that players are not entirely excluded from jackpot rewards, even if they opt out of contributing to the jackpot pool.

### Distinguishing Inventive Steps:

1. Jackpot Insurance Purchase Option: Players may purchase insurance to cover their gameplay session, providing a chance to win a consolation prize if they do not contribute to the jackpot pool.
2. Consolation Payout Mechanism: Players who trigger the jackpot conditions without contributing to the pool may still receive a smaller payout through insurance.
3. Risk Mitigation for Players: The insurance option adds a layer of risk management to the gameplay, giving players more control over their potential outcomes.

### 35 USC 101 Considerations:

This innovative concept is patentable under 35 USC 101 because it introduces a novel method for offering jackpot insurance in DETG systems, enhancing the functionality of electronic gaming systems. The insurance mechanism provides a new way for players to engage with jackpot games by offering a safety net, which is a tangible improvement in player interaction and game outcomes. The system integrates into a practical application by allowing players to manage risk and participate in jackpots without fully committing to the side bet.

### Data Input:

Players input their decision to purchase jackpot insurance when placing their initial bets. The system tracks this data and monitors game outcomes to determine whether a consolation payout is warranted.

### Component Interactions and Procedural Steps:

1. Player A purchases jackpot insurance before placing their bet, while Player B contributes directly to the jackpot pool.
2. The game proceeds, and both players meet the jackpot trigger conditions. Player B wins the full jackpot, while Player A receives a consolation prize through their insurance.

### Data Processing:

The system processes the insurance purchase and monitors game outcomes. If a player with insurance meets the jackpot trigger conditions, the system calculates the appropriate consolation payout based on predefined rules.

### Outputs and Responses:

Players are notified of their insurance coverage and potential payouts. When a jackpot is triggered, the system awards the full jackpot to contributing players and a smaller consolation prize to insured players who did not contribute.

### Data Storage and Reporting:

The system stores data on insurance purchases, game outcomes, and payout amounts. This data may be used for reporting and analysis, allowing casinos to evaluate the effectiveness of the jackpot insurance feature.

### Error Handling and Security Measures:

The system includes error-checking mechanisms to ensure that insurance purchases are properly tracked and that payouts are calculated accurately. Security protocols protect the integrity of the insurance data and prevent tampering.

### End of Interaction:

Once the game session concludes, the system resets the insurance options for the next round. Players may choose to purchase insurance again in future sessions, maintaining ongoing engagement with the feature.

### Innovative Concept 93—Jackpot Qualification Through Skill-Based Bonuses

### Identification of Concept:

This innovative concept introduces Jackpot Qualification through Skill-Based Bonuses in DETG (Dealer-controlled Electronic Table Games) systems. Rather than relying solely on chance-based outcomes to contribute to a jackpot, players may qualify for the jackpot pool or earn additional contributions through skill-based challenges or bonuses during gameplay. These challenges may be specific to each game type, rewarding players for demonstrating a high level of skill or achieving certain milestones.

For example, in a blackjack game, a player may need to make strategic decisions that result in a series of consecutive wins, or in a baccarat game, the player may be required to place accurate predictions on future hands. By tying skill to jackpot eligibility, this concept offers an engaging twist that emphasizes player ability, making it particularly appealing to those who prefer games with a strategic element.

### Sequence Diagram Components:

Notable components involved in the system include:
ETGTs: Players interact with the skill-based bonus system through their individual Electronic Table Game Terminals, where the system tracks skill milestones.
Jackpot Server: This component manages the jackpot pool, including contributions triggered by skill-based challenges or milestones.
Casino Network: Transmits data between the ETGTs and the jackpot server, ensuring real-time updates and contributions based on skill-based achievements.
Player A and Player B: Player A may achieve a skill-based bonus by demonstrating superior strategy in blackjack, while Player B may qualify through accurate predictions in baccarat.
Game Logic Processor: This processes the outcome of skill-based challenges, verifying if a player has met the criteria to earn jackpot qualification or contributions.

### Implementation Details:

To implement this concept, the DETG system introduces skill-based bonus opportunities that are integrated into each game. Players may be required to achieve specific objectives or hit certain milestones based on their gameplay performance.
1. Skill-Based Challenge Configuration: Each game type includes predefined skill-based bonuses. For instance, in blackjack, players may need to win consecutive hands by making optimal strategic decisions, while in baccarat, players may predict the next hand's outcome with high accuracy.
2. Real-Time Tracking: The system tracks player performance in real time, monitoring their actions and decisions to determine if they qualify for a skill-based contribution to the jackpot pool.
3. Jackpot Qualification: Upon meeting the skill criteria, the player's contributions to the jackpot pool may increase, or they may qualify to enter a bonus round for a chance at the jackpot.
4. Dynamic Updates: The system updates each player's progress toward qualifying for the jackpot based on their skill-based achievements, ensuring transparency and ongoing engagement.

### Example Walk-Through Scenario:

1. Player A is engaged in a blackjack game and must win five consecutive hands by making optimal decisions, such as splitting pairs or doubling down at the right time. The system tracks Player A's progress.
2. Player B is playing baccarat and is tasked with accurately predicting the outcome of three consecutive hands (banker, player, or tie). Player B achieves this goal, which qualifies them for a bonus contribution to the jackpot.
3. Both players' skill-based achievements are recognized by the system, increasing their contributions to the shared jackpot pool.

### Player Interaction:

Players interact with the skill-based bonuses by engaging with the specific challenges or milestones presented during gameplay. These challenges vary depending on the game type and provide players with additional opportunities to qualify for the jackpot or increase their contribution. The system introduces a layer of strategy, rewarding players for their skills rather than solely relying on random outcomes.

### Distinguishing Innovative Concepts:

This concept is unique because it integrates skill-based elements into a jackpot system traditionally driven by chance. By introducing skill-based bonuses, the system caters to players who enjoy strategic gameplay and allows them to influence their chances of winning the jackpot through their own decisions. This approach differentiates the system from prior art, which typically emphasizes random outcomes.

### Distinguishing Inventive Steps:

1. Skill-Based Jackpot Qualification: Players may qualify for jackpot contributions or bonuses based on their strategic performance during the game.
2. Dynamic Progress Tracking: The system monitors each player's performance in real time, adjusting their jackpot qualification status as they achieve skill-based milestones.
3. Game-Specific Challenges: Different challenges are tailored to each game type, ensuring that the system remains engaging across various DETGs.

### 35 USC 101 Considerations:

This innovative concept is patentable because it enhances the functionality of DETG systems by integrating skill-based gameplay elements into the jackpot qualification process. This system improves traditional jackpot mechanisms by adding a strategic component, offering players a more interactive and engaging experience. The concept represents a technological improvement in how jackpot pools are managed and influenced by player behavior, making it a specific and practical application.

### Data Input:

Players input strategic decisions during gameplay (e.g., making optimal choices in blackjack or accurate predictions in baccarat), which are tracked by the system. These decisions influence their eligibility for skill-based jackpot contributions.

### Component Interactions and Procedural Steps:

1. Players A and B engage in gameplay, completing skill-based challenges specific to their game type.
2. The system tracks each player's performance and updates their contribution or qualification status for the jackpot pool.
3. Skill-based contributions are awarded to players who meet the challenge criteria, increasing the jackpot pool dynamically.

### Data Processing:

The system processes the player's actions and verifies whether they have met the skill-based challenge criteria. The jackpot server updates the player's contribution based on their performance, reflecting this in the shared jackpot pool.

### Outputs and Responses:

Players receive real-time feedback on their progress toward skill-based bonuses and jackpot qualification. The system provides notifications when a player completes a challenge and qualifies for an additional contribution to the jackpot pool.

### Data Storage and Reporting:

The system stores data on player performance, skill-based challenge outcomes, and contributions to the jackpot pool. This data may be analyzed to evaluate the effectiveness of skill-based bonuses in driving player engagement.

### Error Handling and Security Measures:

The system includes mechanisms to verify the validity of skill-based achievements and ensures that contributions to the jackpot pool are accurately tracked. Security protocols protect against tampering with player performance data.

### End of Interaction:

Once the player has completed their game session, their progress in the skill-based bonus system is reset, but any contributions they made to the jackpot pool remain active. Players may attempt to qualify for new skill-based bonuses in future sessions.

Innovative Concept 94—Progressive Side Bets with Tiered Jackpots

### Identification of Concept:

This innovative concept introduces Progressive Side Bets with Tiered Jackpots in DETG systems. Players may place progressive side bets, which contribute to a tiered jackpot structure. This means that players have the chance to win different levels of jackpots based on their side bet amounts and game outcomes. The system is designed to offer multiple jackpot tiers, such as mini, midi, and mega jackpots, with each tier having different prize levels. Players' side bets contribute to these different jackpot tiers, and specific game outcomes or rare events trigger each tier.

The tiered structure provides a more diversified reward system, where players may aim for lower-tier jackpots with higher frequency or target higher-tier jackpots with larger prizes but lower probability.

### Sequence Diagram Components:

The components involved include:
ETGTs: Players place progressive side bets through their terminals, contributing to the tiered jackpot structure.
Tiered Jackpot Server: This server manages contributions and payouts across multiple jackpot tiers, updating the prize pools dynamically based on player bets.
Casino Network: Facilitates communication between ETGTs and the tiered jackpot server, ensuring that contributions are correctly allocated to each jackpot tier.
Player A and Player B: Players may choose to contribute to different jackpot tiers based on the size of their side bets. Player A may aim for the mini jackpot, while Player B contributes more to aim for the mega jackpot.
Game Logic Processor: Manages the contribution logic and tracks game outcomes to determine when each jackpot tier is triggered.

### Implementation Details:

To implement this system, each ETGT is configured to offer progressive side bets that allow players to contribute to multiple jackpot tiers. Each tier has a different prize pool and payout frequency.
1. Tier Selection: Players may choose how much to contribute to the jackpot through their side bets, with higher contributions unlocking higher jackpot tiers (e.g., mini, midi, or mega jackpots).
2. Tiered Jackpot Pool: The jackpot server tracks contributions and allocates them across the different jackpot tiers. For example, lower side bets may contribute to the mini jackpot, while higher side bets contribute to the midi or mega jackpots.
3. Jackpot Triggers: Specific game outcomes or rare events trigger the different jackpot tiers. For instance, a common event may trigger the mini jackpot, while rarer events trigger the midi and mega jackpots.
4. Real-Time Updates: The system updates the jackpot values for each tier in real time, reflecting contributions from all players.

### Example Walk-Through Scenario:

1. Player A places a small side bet of $5, contributing to the mini jackpot. Meanwhile, Player B places a larger side bet of $20, contributing to both the midi and mega jackpots.
2. During gameplay, Player A wins the mini jackpot when a low-probability event occurs in blackjack. The system awards them the mini jackpot prize, which is a lower payout but occurs more frequently.
3. Later, Player B wins the mega jackpot after hitting a rare game outcome. The mega jackpot is much larger but triggered less frequently.

### Player Interaction:

Players interact with the tiered jackpot system by choosing how much to contribute to each tier through their side bets. The tiered structure allows them to target different levels of jackpots based on their risk preferences. Players aiming for smaller, more frequent payouts may focus on the lower-tier jackpots, while those seeking larger rewards will contribute to the higher tiers.

### Distinguishing Innovative Concepts:

This concept is unique because it offers a tiered jackpot system, giving players multiple paths to potential wins based on their contributions. By splitting the jackpot into different tiers, the system increases engagement by offering more frequent, smaller payouts alongside rarer, larger ones. This tiered approach is a novel twist on traditional progressive jackpots, which typically offer a single prize pool.

### Distinguishing Inventive Steps:

1. Tiered Jackpot Structure: Players may contribute to different jackpot tiers based on their side bets, allowing for multiple prize levels.
2. Real-Time Jackpot Allocation: The system dynamically allocates player contributions across the various jackpot tiers, ensuring fairness and transparency.
3. Frequent Payouts at Lower Tiers: The lower-tier jackpots (e.g., mini) are designed to trigger more frequently, keeping players engaged while they aim for higher-tier rewards.

### 35 USC 101 Considerations:

This innovative concept is patentable because it introduces a new tiered jackpot structure that enhances the functionality of DETG systems. By offering multiple jackpot levels with varying prize sizes and win probabilities, the system improves player engagement and creates a more diverse and exciting gaming experience. The tiered structure represents a specific improvement over traditional single-tier progressive jackpots, offering players more control and flexibility in their betting strategies.

### Data Input:

Players input their side bet amounts and choose which jackpot tiers they want to contribute to. This data is transmitted to the tiered jackpot server, which processes the contributions and updates the jackpot pools.

### Component Interactions and Procedural Steps:

1. Players A and B place progressive side bets, with Player A contributing to the mini jackpot and Player B contributing to the midi and mega jackpots.
2. The tiered jackpot server tracks the contributions and updates the jackpot pools for each tier in real time.
3. When a game outcome triggers a jackpot, the system awards the appropriate tier prize to the winning player.

### Data Processing:

The system processes player side bets and allocates contributions to the appropriate jackpot tiers. It also tracks game outcomes to determine when each jackpot tier is triggered, ensuring that payouts are handled correctly.

### Outputs and Responses:

Players receive real-time updates on the current jackpot values for each tier, along with notifications when a jackpot is triggered. The system displays the winner and the payout amount, keeping all players informed.

### Data Storage and Reporting:

The system stores data on player contributions, jackpot triggers, and payouts across the different tiers. This data is used for reporting and analysis, allowing casinos to optimize the tiered jackpot system.

### Error Handling and Security Measures:

The system includes safeguards to ensure that contributions are accurately allocated to the correct jackpot tiers and that payouts are processed securely. Security protocols prevent tampering with jackpot values or game outcomes.

### End of Interaction:

Once a jackpot tier is won, the system resets the prize pool for that tier and begins collecting contributions for the next round. Players may continue placing side bets to participate in future jackpot tiers.

### Innovative Concept 95—Mystery Jackpot Clues Feature

### Identification of Concept:

This innovative concept introduces a Mystery Jackpot Clues Feature in DETG systems. Players are provided with periodic clues or hints about when a mystery jackpot may trigger, heightening engagement and excitement. These clues may be related to upcoming game rounds, certain game outcomes, or betting patterns, giving players subtle insights into when the jackpot is more to be won. The system keeps players guessing and engaged by offering these clues at random intervals or when certain conditions are met.

Clues may be presented as visual cues, cryptic messages, or changes in gameplay dynamics, adding an element of mystery and intrigue to the jackpot system. This feature keeps players actively involved, as they try to decipher the clues to predict the jackpot trigger.

### Sequence Diagram Components:

Notable components involved in this system include:
ETGTs: Players receive jackpot clues through their terminals during gameplay, with visual or textual prompts providing hints about potential jackpot triggers.
Jackpot Clue Generator: This server generates and delivers the mystery clues to players based on pre-programmed conditions or random intervals.
Casino Network: Manages communication between the ETGTs and the jackpot server, transmitting clues and player responses in real-time.
Players A and B: Players receive clues and attempt to interpret them to increase their chances of winning the mystery jackpot.
Game Logic Processor: Tracks the progression of the game and determines when clues should be presented to players based on certain gameplay events or conditions.

### Implementation Details:

To implement this feature, the DETG system includes a clue generation module that randomly or conditionally sends clues to players. The system may be configured to deliver clues based on certain game events or at regular intervals, keeping players engaged.
1. Clue Generation: The system generates clues based on a variety of factors, such as the number of rounds played, betting patterns, or specific game outcomes. These clues are then delivered to players during gameplay.
2. Clue Delivery: Clues are sent to players in the form of visual or textual prompts on their ETGTs, providing hints about when the mystery jackpot may trigger or which game events are relevant to the jackpot.
3. Player Interpretation: Players must interpret the clues to maximize their chances of winning the jackpot. This adds an element of strategy to the game, as players adjust their betting behavior or decisions based on the clues.
4. Mystery Jackpot Trigger: The jackpot is triggered based on pre-defined game conditions, but the clues provide players with an indication of when these conditions may be met, increasing engagement.

### Example Walk-Through Scenario:

1. Player A is playing roulette and receives a cryptic clue on their ETGT that says, “The wheel spins in your favor.” The player interprets this as a sign that a jackpot trigger may occur in the next few rounds.
2. Player B playing blackjack receives a clue that reads, “A streak of victories may bring riches,” hinting that consecutive wins may lead to a jackpot trigger.
3. Both players adjust their betting behavior based on the clues, placing larger bets in anticipation of the potential jackpot trigger.

### Player Interaction:

Players interact with the mystery jackpot system by receiving and interpreting clues during gameplay. The clues provide subtle hints about when the jackpot may trigger, encouraging players to stay engaged and adjust their strategies. This feature adds an extra layer of excitement to the game, as players feel more involved in predicting the jackpot outcome.

### Distinguishing Innovative Concepts:

This concept is distinct because it introduces a clue-based system for mystery jackpots, which is not commonly found in traditional jackpot mechanisms. By providing players with hints or clues, the system adds a strategic layer to jackpot gameplay, encouraging players to actively engage with the game and make decisions based on the information provided. The mystery element differentiates this system from conventional random jackpots, where players have no insight into potential triggers.

### Distinguishing Inventive Steps:

1. Clue-Based Jackpot Hints: The system provides players with periodic clues about potential jackpot triggers, adding a layer of strategy and excitement.
2. Dynamic Clue Generation: Clues are generated based on gameplay conditions, random intervals, or player behavior, ensuring that the clues are always relevant and engaging.
3. Strategic Player Engagement: Players must interpret the clues and adjust their gameplay to maximize their chances of winning the jackpot, adding a new level of involvement.

### 35 USC 101 Considerations:

This innovative concept is patentable because it introduces a specific improvement in mystery jackpot systems by incorporating a clue-based feature that enhances player engagement and strategy. The system improves the functionality of DETG platforms by offering players hints about jackpot triggers, making the gameplay experience more interactive and engaging. The clue generation and delivery system represents a tangible improvement over traditional mystery jackpots, offering a practical application in gaming environments.

### Data Input:

The system collects gameplay data, such as rounds played, player bets, and game outcomes. This data is used to determine when and how clues should be generated and delivered to players.

### Component Interactions and Procedural Steps:

1. Players A and B receive clues based on the progression of their respective games.
2. The system tracks gameplay conditions and generates clues that hint at potential jackpot triggers.
3. Players interpret the clues and adjust their betting behavior accordingly, increasing their chances of winning the mystery jackpot.

### Data Processing:

The system processes game data and applies pre-defined conditions to generate clues. The clues are delivered to players in real-time, based on gameplay progression and events.

### Outputs and Responses:

Players receive real-time clues on their ETGTs, prompting them to adjust their strategies. The system also notifies players when a jackpot is triggered, providing feedback on the effectiveness of the clues.

### Data Storage and Reporting:

The system stores data on clue generation, player responses, and jackpot triggers. This data may be used for reporting and analysis, helping casinos evaluate the effectiveness of the mystery clue feature.

### Error Handling and Security Measures:

The system includes safeguards to ensure that clues are generated fairly and accurately based on gameplay conditions. Security protocols protect the integrity of the clues and the jackpot system, preventing manipulation or unfair advantages.

### End of Interaction:

After each game session, the system resets the clue generation process for the next round. Players may continue receiving clues in future sessions, keeping them engaged with the mystery jackpot system.

### Innovative Concept 96—Time-Based Jackpot Contribution Boosts

### Identification of Concept:

This innovative concept introduces Time-Based Jackpot Contribution Boosts in DETG (Dealer-controlled Electronic Table Games) systems. This feature allows players to increase their contributions to the jackpot pool during specific time windows, such as hourly or daily “boost” periods. During these periods, player contributions to the jackpot pool are multiplied, offering them an enhanced opportunity to grow the jackpot or increase their chances of winning. The boosts may be triggered by the casino to encourage participation during off-peak hours, or during special promotions to increase player engagement.

For example, during a designated “happy hour” or promotional period, contributions made to the jackpot pool may be doubled or tripled. This provides additional excitement and incentives for players to participate during these specified time frames.

### Sequence Diagram Components:

Notable components involved in this system include:
ETGTs: Players interact with the boost system through their individual Electronic Table Game Terminals. During boost periods, the system displays information about the active contribution multipliers.
Boost Timer Module: A server or module that tracks the timing of boost periods and applies the contribution multipliers when players place bets during these time frames.
Jackpot Server: Manages the overall jackpot pool and dynamically adjusts contributions based on the applied multipliers during boost periods.
Casino Network: Facilitates real-time updates of jackpot contributions and displays the boosted pool growth across all ETGTs.
Player A and Player B: Players participate in games during a boost period, with Player A contributing during the boost window and benefiting from the multiplier, while Player B contributes before the boost begins.
Game Logic Processor: This component applies the contribution multiplier when a player places a bet during an active boost period.

### Implementation Details:

The implementation of time-based jackpot contribution boosts may require integration with the ETGTs and the jackpot server to track active boost periods and apply multipliers accordingly.
1. Boost Period Configuration: The casino sets designated boost periods, such as a “happy hour” or promotional events, where player contributions to the jackpot are multiplied (e.g., 2× or 3×). These periods may be configured to occur at specific times of the day or during special events.
2. Real-Time Contribution Multipliers: During the boost period, any bets placed on DETGs are automatically multiplied. For example, if a player contributes $10 during a 2× boost period, $20 is added to the jackpot pool.
3. Player Notifications: Players are notified of the upcoming or active boost periods via visual cues or pop-up notifications on their ETGTs. This ensures they are aware of the opportunity to maximize their jackpot contributions.
4. Dynamic Jackpot Growth: The jackpot server tracks all contributions made during the boost periods and adjusts the jackpot pool accordingly, ensuring that the growth is transparent and visible to all players in real time.

### Example Walk-Through Scenario:

1. Player A logs in to a blackjack DETG during a “happy hour” boost period, where all jackpot contributions are doubled. They place a $50 bet, with $5 normally going to the jackpot pool. During the boost, this contribution is doubled, and $10 is added to the pool.
2. Player B places a similar bet before the boost period begins, contributing the standard $5 to the jackpot pool.
3. As the boost period progresses, players who contribute during this time window see the jackpot pool grow faster than usual, creating excitement and encouraging further participation.

### Player Interaction:

Players may participate in the jackpot boost by simply placing their bets during the designated boost period. The system automatically applies the multiplier to their contributions, increasing the jackpot pool. Players are incentivized to play more during these periods, as their bets contribute more significantly to the jackpot, enhancing their overall gaming experience.

### Distinguishing Innovative Concepts:

This concept is novel because it introduces time-based multipliers for jackpot contributions, creating strategic windows for players to maximize their involvement. Unlike traditional jackpot systems where contributions are fixed, this system introduces dynamic boost periods that reward players for participating at specific times. This concept encourages higher player engagement, especially during off-peak hours or promotional events.

### Distinguishing Inventive Steps:

1. Time-Based Contribution Boosts: Players' jackpot contributions are multiplied during specific time windows, adding a dynamic element to the gameplay.
2. Real-Time Jackpot Growth: The system updates the jackpot pool in real-time, reflecting the increased contributions during the boost periods.
3. Player Notifications and Engagement: Players are informed of active or upcoming boost periods, encouraging them to participate more frequently during these windows.

### 35 USC 101 Considerations:

This innovative concept is patentable under 35 USC 101 as it introduces a novel, non-abstract improvement to jackpot contribution systems by incorporating time-based multipliers. This system enhances the functionality of DETG platforms by creating strategic windows for increased contributions, thereby improving player engagement and interaction. The practical application of boost periods to increase jackpot growth offers a tangible improvement in casino operations and player experience.

### Data Input:

Players place their bets during the boost period, and the system tracks the timing and value of these contributions. The data is transmitted to the jackpot server, where the contribution multiplier is applied.

### Component Interactions and Procedural Steps:

1. Players A and B place bets during and outside the boost period, with Player A benefiting from the contribution multiplier.
2. The system tracks the timing of the bets and applies the appropriate multiplier during the boost window.
3. The jackpot pool is updated in real-time, reflecting the increased contributions from players participating in the boost period.

### Data Processing:

The system processes the player contributions, applies the boost multiplier during the designated periods, and dynamically updates the jackpot pool based on these contributions.

### Outputs and Responses:

Players receive real-time updates on the growing jackpot pool during the boost period. The system also notifies players of upcoming or active boost windows, encouraging participation.

### Data Storage and Reporting:

The system stores data on player contributions, timing of bets, and the application of boost multipliers. This data is used for reporting and analysis, allowing the casino to optimize the scheduling of boost periods.

### Error Handling and Security Measures:

The system includes error-checking mechanisms to ensure that boost multipliers are applied correctly based on the timing of bets. Security protocols prevent tampering with the timing or multiplier settings.

### End of Interaction:

Once the boost period concludes, the system reverts to standard contribution rates for subsequent bets. Players may continue contributing to the jackpot pool at the normal rate until the next boost period is activated.

### Innovative Concept 97—Jackpot Shared Among Multiple Winners

### Identification of Concept:

This innovative concept introduces Jackpot Shared Among Multiple Winners in DETG systems. Instead of a single player winning the entire jackpot, this system allows for the jackpot to be distributed among multiple players who meet certain criteria or contribute to a shared win condition. The jackpot is divided based on factors such as contribution amount, bet size, or game performance, ensuring that multiple players are rewarded for their participation in the jackpot pool.

For example, if a mystery jackpot is triggered, multiple players who contributed to the pool during the winning game round may receive a portion of the prize based on their bet size or other qualifying factors. This feature promotes a sense of community among players and increases the likelihood of more participants receiving a payout.

### Sequence Diagram Components:

Notable components involved include:
ETGTs: Players contribute to the jackpot pool through their terminals. When the jackpot is triggered, the system calculates the share of the jackpot for each qualifying player.
Jackpot Server: This server manages the contributions and payout distribution, calculating each player's share of the jackpot based on predetermined criteria.
Casino Network: Facilitates communication between ETGTs and the jackpot server, ensuring that contributions are tracked and payouts are distributed in real-time.
Players A, B, and C: Players contribute to the jackpot pool, and when the jackpot is triggered, each player receives a portion based on their contributions or game performance.
Payout Logic Processor: This component determines how the jackpot is divided among multiple winners based on criteria such as contribution size, bet size, or game outcomes.

### Implementation Details:

The implementation of this concept involves configuring the jackpot server to track individual player contributions and distribute the jackpot accordingly when it is triggered.
1. Shared Jackpot Configuration: The system is set up to divide the jackpot among multiple players based on factors such as their contribution amount, bet size, or performance during the game round in which the jackpot is triggered.
2. Contribution Tracking: The system tracks how much each player contributes to the jackpot pool. When the jackpot is triggered, the server calculates each player's share based on these contributions or other relevant criteria.
3. Real-Time Payout Distribution: Once the jackpot is triggered, the system automatically distributes the prize pool among the qualifying players. Players receive their payouts in real time, with notifications displayed on their ETGTs.
4. Multiple Winner Criteria: The system may be configured with different criteria for multiple winners, such as sharing the jackpot equally among all players who contributed during the winning round or awarding larger shares to those with higher contributions or better game performance.

### Example Walk-Through Scenario:

1. Player A, Player B, and Player C are all contributing to a shared jackpot pool while playing different games (e.g., blackjack, baccarat, roulette).
2. The jackpot is triggered when Player C hits a rare outcome in roulette. However, instead of receiving the entire jackpot, the prize is divided among all three players based on their contributions. Player C receives the largest share due to their game outcome, while Players A and B receive smaller portions based on their contributions.
3. All three players are notified of their winnings and see the breakdown of the jackpot distribution on their ETGTs.

### Player Interaction:

Players interact with the system by contributing to the shared jackpot pool through their regular gameplay. When the jackpot is triggered, they receive a portion of the prize based on their contributions or performance. This shared win mechanism encourages players to participate more actively, as they know that multiple participants may win, not just a single player.

### Distinguishing Innovative Concepts:

This concept is unique because it shifts away from the traditional “winner-takes-all” jackpot system. By distributing the jackpot among multiple players, the system creates a more inclusive and engaging environment, where participants feel that they have a greater chance of receiving a payout. This system fosters a sense of community and fairness among players, making it more appealing than conventional jackpot systems.

### Distinguishing Inventive Steps:

1. Shared Jackpot Distribution: The jackpot is divided among multiple players based on their contributions or performance, ensuring that more participants are rewarded.
2. Customizable Criteria for Multiple Winners: The system may be configured to distribute the jackpot based on various factors, such as contribution size or bet size, allowing for flexible jackpot distribution.
3. Real-Time Payout Notifications: Players receive instant feedback on their share of the jackpot, increasing excitement and engagement.

### 35 USC 101 Considerations:

This innovative concept is patentable because it introduces a novel method of distributing jackpot prizes among multiple players, enhancing the functionality of traditional jackpot systems. The shared jackpot model improves player engagement by offering multiple payout opportunities, fostering a more inclusive gaming environment. The system integrates into a practical application by enabling real-time distribution of jackpots across multiple players, representing a significant improvement over conventional winner-takes-all systems.

### Data Input:

Players contribute to the jackpot pool through their bets. The system tracks each player's contributions and game outcomes, using this data to calculate their share of the jackpot when it is triggered.

### Component Interactions and Procedural Steps:

1. Players A, B, and C contribute to the jackpot pool through their respective games.
2. The system tracks contributions and game outcomes to determine how the jackpot should be distributed among the participants.
3. When the jackpot is triggered, the system calculates each player's share and distributes the winnings in real time.

### Data Processing:

The system processes player contributions and game outcomes, applying the payout logic to divide the jackpot among the qualifying participants. The jackpot server ensures that each player's share is accurately calculated based on the predefined distribution criteria.

### Outputs and Responses:

Players receive real-time notifications of their share of the jackpot, with the system displaying the amount won and the distribution breakdown. This transparency enhances the gaming experience and increases player satisfaction.

### Data Storage and Reporting:

The system stores data on player contributions, jackpot triggers, and payouts. This information may be used for reporting and analysis, allowing casinos to optimize the shared jackpot system and evaluate player engagement.

### Error Handling and Security Measures:

The system includes safeguards to ensure that contributions and payouts are accurately tracked and distributed. Security protocols prevent tampering with the jackpot pool or the distribution criteria, ensuring fairness for all participants.

### End of Interaction:

Once the jackpot is distributed among multiple players, the system resets the pool for the next round of contributions. Players may continue contributing to future jackpots, knowing that they have the potential to win a share of the prize.

### Innovative Concept 98—Jackpot Triggered by Unlikely Game Events

### Identification of Concept:

This innovative concept introduces Jackpot Triggered by Unlikely Game Events in DETG systems. In this system, the jackpot is triggered by extremely rare or low-probability game outcomes, such as hitting a specific sequence of numbers in roulette, achieving a perfect hand in blackjack, or drawing an exact combination of cards in baccarat. These unlikely events serve as the jackpot trigger, adding an extra layer of excitement and anticipation to the gameplay. Players who achieve these rare outcomes are rewarded with the jackpot prize, making the win feel even more significant.

For example, in a game of roulette, a player may trigger the jackpot by hitting the same number five times in a row. In blackjack, a player may win the jackpot by drawing five consecutive “blackjacks” without losing a hand.

### Sequence Diagram Components:

Notable components involved in this system include:
ETGTs: Players interact with the game and aim to achieve the rare game outcomes that trigger the jackpot.
Jackpot Server: Monitors all game outcomes and determines when a rare or unlikely event has occurred, triggering the jackpot.
Casino Network: Facilitates communication between the ETGTs and the jackpot server, ensuring that rare events are recognized and the jackpot is awarded in real time.
Players A and B: Participants in various DETG games, where they aim to hit the rare events that trigger the jackpot.
Game Logic Processor: Tracks all game outcomes and identifies when a specific rare event occurs, communicating this to the jackpot server to trigger the prize.

### Implementation Details:

To implement this system, the game logic processor may be configured to monitor game outcomes and identify rare events that are predefined as jackpot triggers.
1. Rare Event Definition: The system is configured to recognize specific rare events, such as drawing an exact combination of cards in baccarat, achieving a perfect blackjack hand multiple times in a row, or hitting a series of improbable outcomes in roulette.
2. Trigger Monitoring: The game logic processor continuously monitors each game for these rare outcomes. When a qualifying event occurs, the system sends a signal to the jackpot server to trigger the prize.
3. Real-Time Jackpot Award: Once a rare event triggers the jackpot, the system immediately notifies the winning player and awards the prize. The jackpot server resets the pool for the next round of contributions.

### Example Walk-Through Scenario:

1. Player A is playing roulette and places a bet on the number 17. The number 17 hits five times in a row, a rare event that the system recognizes as a jackpot trigger.
2. The jackpot server immediately awards the jackpot to Player A, notifying them of the win on their ETGT.
3. Player B is playing blackjack and draws three consecutive perfect hands (e.g., drawing a blackjack each time).

This event also triggers a different jackpot, and Player B is awarded the prize.

### Player Interaction:

Players interact with the system by participating in the normal gameplay of DETGs, with the added excitement of knowing that rare game events may trigger a jackpot. The system increases player engagement by providing additional opportunities to win based on improbable but possible outcomes, making the jackpot feel even more significant when triggered.

### Distinguishing Innovative Concepts:

This concept is distinct because it ties the jackpot trigger to rare or unlikely game outcomes, rather than random events or specific contributions. By linking the jackpot to unique in-game achievements, the system creates a deeper connection between gameplay and the potential for winning the jackpot. This approach rewards players for hitting rare, memorable moments during gameplay.

### Distinguishing Inventive Steps:

1. Rare Event Jackpot Triggers: The jackpot is triggered by predefined, unlikely game events, such as rare card combinations or improbable roulette outcomes.
2. Real-Time Monitoring of Rare Events: The system continuously tracks game outcomes to identify when rare events occur, ensuring that the jackpot is triggered immediately.
3. Unique Gameplay Connection: The system creates a direct link between in-game achievements and jackpot wins, making the trigger feel more significant and memorable.

### 35 USC 101 Considerations:

This innovative concept is patentable under 35 USC 101 because it introduces a novel, non-abstract method for triggering jackpots based on rare or unlikely game outcomes. This system enhances the functionality of DETG platforms by providing an additional layer of excitement and engagement, as players strive to achieve rare game events. The integration of jackpot triggers based on unique game achievements represents a specific improvement in gaming mechanics and offers a practical application in casino environments.

### Data Input:

The system tracks all game outcomes in real time, monitoring for specific rare events that have been predefined as jackpot triggers. Player bets and game results are used as input to determine when a jackpot-triggering event occurs.

### Component Interactions and Procedural Steps:

1. Players A and B participate in gameplay, aiming to achieve rare outcomes in their respective games.
2. The game logic processor tracks each game outcome and identifies when a rare event occurs.
3. The system triggers the jackpot, awarding the prize to the player who achieved the rare event, and resets the jackpot pool for the next round.

### Data Processing:

The system processes game results in real time, comparing outcomes against a predefined list of rare events that trigger the jackpot. When a match is found, the jackpot server is notified to award the prize and reset the pool.

### Outputs and Responses:

Players receive real-time notifications when they achieve a jackpot-triggering event. The system displays the jackpot win on the ETGT and awards the prize immediately, creating a memorable gameplay experience.

### Data Storage and Reporting:

The system stores data on rare event occurrences, jackpot triggers, and payouts. This information may be used for reporting and analysis, allowing casinos to evaluate the effectiveness of the rare event jackpot triggers.

### Error Handling and Security Measures:

The system includes safeguards to ensure that rare events are accurately identified and that jackpots are awarded correctly. Security protocols prevent tampering with game outcomes or jackpot triggers, ensuring fairness for all players.

### End of Interaction:

Once the jackpot is awarded for a rare event, the system resets the jackpot pool for the next round of contributions. Players may continue participating in future games, with the potential to trigger the jackpot through additional rare game events.

### Innovative Concept 99—Player Contribution Tracking for Jackpot Eligibility

### Identification of Concept:

This innovative concept introduces Player Contribution Tracking for Jackpot Eligibility in DETG (Dealer-controlled Electronic Table Games) systems. The system tracks each player's contributions to the jackpot pool over time and uses this information to determine their eligibility for triggering or receiving a jackpot payout. Instead of relying solely on real-time contributions or game outcomes, this system ensures that players who contribute consistently or significantly over a set period are rewarded with higher chances of winning the jackpot or receiving larger portions of the prize.

The contribution tracking system accumulates player data, such as the total amount wagered and contributed to the jackpot pool, and applies this data to increase jackpot eligibility or payout amounts. This approach rewards players for their sustained participation and incentivizes long-term engagement with the game.

### Sequence Diagram Components:

The notable components involved include:
ETGTs: Players place bets through their Electronic Table Game Terminals, with a portion of each bet contributing to the jackpot pool. The system tracks these contributions over time.
Player Contribution Tracker: A server that logs and monitors each player's contributions to the jackpot pool, maintaining a history of player activity.
Jackpot Server: Manages the jackpot pool and uses the contribution data to calculate player eligibility or payout amounts when the jackpot is triggered.
Casino Network: Facilitates communication between the ETGTs, the player contribution tracker, and the jackpot server, ensuring real-time tracking and updates.
Player A, Player B, and Player C: Each player's contributions are tracked individually, influencing their chances of winning the jackpot or receiving larger portions of the prize when the jackpot is triggered.
Game Logic Processor: Monitors gameplay outcomes and determines jackpot triggers, while the player contribution tracker determines eligibility and payout amounts based on contribution data.

### Implementation Details:

To implement this system, the ETGTs are connected to the player contribution tracker, which logs the total contributions each player makes to the jackpot pool.
1. Contribution Logging: Each time a player places a bet, the system records the contribution to the jackpot pool. This information is stored and tracked over time to assess player eligibility for the jackpot.
2. Eligibility Criteria: The system may be configured with specific eligibility criteria, such as requiring players to contribute a certain amount over a set number of games or sessions. Players who meet these criteria may have higher odds of triggering the jackpot or receiving a larger payout.
3. Real-Time Updates: As players continue to wager, the system updates their contribution data in real time. Players may be notified of their contribution status or progress toward qualifying for a higher jackpot chance.
4. Jackpot Payout Distribution: When the jackpot is triggered, the player contribution tracker works with the jackpot server to determine how the prize is distributed, based on each player's contribution history. Players who have contributed more may receive a larger share of the jackpot.

### Example Walk-Through Scenario:

1. Player A has been contributing consistently to the jackpot pool over several game sessions, placing high bets in blackjack. Player B has contributed smaller amounts less frequently.
2. When the jackpot is triggered by an event in Player C's baccarat game, the system calculates the payouts for all eligible players based on their contribution history. Player A receives a larger portion of the jackpot due to their higher contributions, while Player B receives a smaller share.
3. All players are notified of their winnings, and their contribution data is reset for the next jackpot cycle.

### Player Interaction:

Players interact with the system by placing regular bets on DETGs. Their contributions to the jackpot pool are tracked over time, and they may see their progress toward increased eligibility for a jackpot payout. This encourages long-term engagement, as players know their sustained contributions will enhance their chances of winning or increase their share of the prize.

### Distinguishing Innovative Concepts:

This concept is unique because it introduces a contribution-tracking mechanism that rewards players for sustained participation in the jackpot pool. Instead of a random jackpot trigger or a flat contribution model, this system incentivizes players to continue betting and contributing over time, increasing their chances of winning or receiving larger payouts. This approach contrasts with traditional systems, where jackpots are typically awarded based on a single event or contribution.

### Distinguishing Inventive Steps:

1. Contribution-Based Eligibility: The system tracks each player's contributions to the jackpot pool over time, increasing their eligibility for a jackpot payout based on sustained participation.
2. Dynamic Payout Distribution: Jackpot payouts are adjusted based on each player's contribution history, rewarding those who have contributed more over multiple game sessions.
3. Long-Term Player Engagement: By tracking contributions and rewarding sustained participation, the system encourages players to stay engaged with the game over the long term.

### 35 USC 101 Considerations:

This innovative concept is patentable under 35 USC 101 as it introduces a non-abstract, technical improvement to DETG systems by implementing a contribution-tracking mechanism that enhances jackpot eligibility and payout distribution. This system offers a practical application by improving how jackpot pools are managed and distributed, providing a tangible incentive for players to remain engaged. The contribution-tracking feature adds a new dimension to jackpot systems, rewarding long-term participation and offering a clear improvement over conventional methods.

### Data Input:

Players input their bets, and the system tracks the contribution portion of each wager. This data is logged and accumulated over time to assess eligibility for jackpot payouts.

### Component Interactions and Procedural Steps:

1. Players A, B, and C place bets on various DETGs, with a portion of each bet contributing to the jackpot pool.
2. The system logs each player's contributions, tracking their activity over multiple game sessions.
3. When the jackpot is triggered, the system calculates payouts based on each player's contribution history, distributing the prize accordingly.

### Data Processing:

The system processes player contribution data, updating each player's contribution total in real time. When the jackpot is triggered, the system uses this data to determine eligibility and payout amounts, ensuring fair distribution based on each player's participation.

### Outputs and Responses:

Players are notified of their progress toward jackpot eligibility and receive real-time updates on their contribution status. When the jackpot is triggered, the system displays the payout amounts for each player based on their contribution history.

### Data Storage and Reporting:

The system stores data on player contributions, jackpot triggers, and payout distributions. This information may be used for reporting and analysis, allowing casinos to evaluate player engagement and optimize the contribution-tracking system.

### Error Handling and Security Measures:

The system includes error-checking mechanisms to ensure that player contributions are tracked accurately and that jackpot payouts are distributed fairly. Security protocols prevent tampering with contribution data or payout calculations, ensuring transparency and fairness.

### End of Interaction:

Once the jackpot is triggered and distributed, the system resets each player's contribution data for the next cycle. Players may continue contributing to future jackpots, with their contributions tracked and logged for future eligibility.

### Innovative Concept 100—Jackpot Decay Mechanism

### Identification of Concept:

This innovative concept introduces a Jackpot Decay Mechanism in DETG systems, where the jackpot pool decreases gradually if it is not triggered within a specified period. The jackpot decay mechanism is designed to add urgency to the gameplay by encouraging players to place more bets and trigger the jackpot before it decreases. This system prevents jackpots from growing indefinitely without being won, providing a balanced approach to jackpot management.

The decay is applied progressively, reducing the jackpot pool at predefined intervals or based on certain conditions (e.g., after a set number of game rounds). This mechanism ensures that the jackpot remains attainable, while also creating a sense of urgency for players to participate before the pool diminishes.

### Sequence Diagram Components:

Notable components involved in this system include:
ETGTs: Players place bets on their terminals, contributing to the jackpot pool. The ETGTs also display notifications about the jackpot decay and any remaining time before the pool decreases.
Jackpot Server: Manages the jackpot pool and applies the decay mechanism at predefined intervals. The server tracks the growth of the jackpot and reduces the pool if it is not triggered within a certain time frame.
Casino Network: Facilitates communication between the ETGTs and the jackpot server, ensuring that decay updates are displayed in real-time and contributions are accurately tracked.
Players A, B, and C: Players interact with the system, contributing to the jackpot pool and attempting to trigger it before the decay mechanism reduces the prize amount.
Game Logic Processor: Tracks the timing of the jackpot and determines when the decay mechanism should be applied, reducing the pool if the jackpot remains untriggered.

### Implementation Details:

To implement the jackpot decay mechanism, the system introduces a decay timer that tracks how long the jackpot has been active without being triggered.
1. Decay Timer Configuration: The system is configured with a decay timer that starts when the jackpot pool reaches a certain size or has been active for a predefined period. If the jackpot is not triggered within this window, the decay mechanism reduces the pool by a fixed amount or percentage.
2. Player Notifications: Players are notified of the upcoming decay via their ETGTs, with a countdown timer indicating when the decay will take effect. This creates urgency, encouraging players to place more bets to trigger the jackpot before the pool decreases.
3. Progressive Decay: If the jackpot is not triggered within the initial decay window, the system continues to apply decay at regular intervals, reducing the pool further until it is either triggered or reset.
4. Dynamic Jackpot Growth: Even as the decay mechanism reduces the pool, players' contributions may still increase the jackpot. The system balances growth and decay to maintain engagement.

### Example Walk-Through Scenario:

1. Player A, Player B, and Player C are all contributing to a shared jackpot pool in different DETGs (e.g., blackjack, roulette, and baccarat). The jackpot pool has been growing for several hours without being triggered.
2. The system activates the jackpot decay mechanism, starting a countdown timer of 30 minutes before the first decay reduction. Players are notified via their ETGTs that the jackpot will decrease by 10% if it is not triggered within the next 30 minutes.
3. As the timer ticks down, Player B places higher bets, hoping to trigger the jackpot before the decay. However, the timer reaches zero, and the jackpot pool decreases by 10%. The system starts another countdown, notifying players of the next potential decay.

### Player Interaction:

Players are motivated to place bets and trigger the jackpot before the decay mechanism reduces the pool. The countdown timer displayed on their ETGTs creates urgency, encouraging players to increase their participation. This feature adds a strategic element to the game, as players try to maximize their chances of winning the full jackpot before it begins to shrink.

### Distinguishing Innovative Concepts:

This concept is novel because it introduces a time-based decay mechanism that reduces the jackpot pool if it is not triggered within a set period. Traditional jackpot systems typically allow the pool to grow indefinitely until it is won, but the decay mechanism adds a new layer of urgency and strategy to the game. By encouraging players to act before the jackpot decreases, the system drives higher engagement and participation.

### Distinguishing Inventive Steps:

1. Time-Based Jackpot Decay: The jackpot pool decreases at regular intervals if it is not triggered, adding urgency to the gameplay and encouraging players to act quickly.
2. Dynamic Player Notifications: Players are notified of the upcoming decay, with real-time countdown timers displayed on their ETGTs, creating a sense of urgency and increasing engagement.
3. Balanced Growth and Decay: The system balances jackpot growth through player contributions with the decay mechanism, ensuring that the pool remains attainable without growing indefinitely.

### 35 USC 101 Considerations:

This innovative concept is patentable under 35 USC 101 as it introduces a non-abstract, technical improvement to jackpot management in DETG systems. By incorporating a time-based decay mechanism, the system adds urgency to the gameplay, encouraging higher player participation and engagement. The practical application of the decay mechanism ensures that jackpots do not grow indefinitely and creates a dynamic gaming experience that balances growth and reduction in the jackpot pool.

### Data Input:

The system tracks player bets and contributions to the jackpot pool. It also monitors the time elapsed since the jackpot was last triggered, using this data to determine when the decay mechanism should be applied.

### Component Interactions and Procedural Steps:

1. Players A, B, and C place bets, contributing to the jackpot pool. The system tracks the timing of the jackpot and starts the decay timer.
2. As the decay timer reaches zero, the system reduces the jackpot pool by a predefined percentage or amount. Players are notified of the decay and encouraged to act quickly to avoid further reductions.
3. If the jackpot is triggered, the decay mechanism is reset, and the pool is awarded to the winning player.

### Data Processing:

The system processes player contributions and monitors the time elapsed since the jackpot was last triggered. The decay mechanism is applied based on predefined conditions, reducing the pool if it remains untriggered.

### Outputs and Responses:

Players receive real-time notifications of the upcoming decay, with countdown timers displayed on their ETGTs. The system updates the jackpot pool in real time, showing the reduced prize amount after each decay.

### Data Storage and Reporting:

The system stores data on jackpot growth, decay events, and player contributions. This data may be used for reporting and analysis, allowing casinos to evaluate the effectiveness of the decay mechanism and optimize its application.

### Error Handling and Security Measures:

The system includes safeguards to ensure that the decay mechanism is applied fairly and accurately. Security protocols prevent tampering with the decay timer or jackpot pool, ensuring transparency and fairness for all players.

### End of Interaction:

Once the jackpot is triggered or fully decays, the system resets the pool and decay timer for the next round of contributions. Players may continue participating in future jackpots, knowing that the pool will be reduced if it remains untriggered for an extended period.

### Innovative Concept 101—Jackpot Linked to Tournament Leaderboard

### Identification of Concept:

This innovative concept introduces a Jackpot Linked to Tournament Leaderboard in DETG systems, where players compete on a leaderboard and their ranking directly affects their eligibility for or share of the jackpot. In this system, players earn points based on their game performance, and the top-ranking players on the leaderboard qualify for the jackpot or receive larger portions of the prize when the jackpot is triggered.

The tournament leaderboard adds a competitive element to the gameplay, encouraging players to perform well and climb the rankings. As players progress up the leaderboard, their chances of winning the jackpot or receiving a significant payout increase, adding an extra layer of excitement to the game.

### Sequence Diagram Components:

Notable components involved include:
ETGTs: Players compete in various DETG games, earning points based on their performance. Their points and rankings are displayed on the tournament leaderboard, which is visible on their ETGTs.
Tournament Leaderboard Server: Tracks player performance across all participating DETGs, updating the leaderboard in real time. The server also determines jackpot eligibility and payout amounts based on leaderboard rankings.
Jackpot Server: Manages the jackpot pool and uses leaderboard data to determine how the jackpot is distributed among top-ranking players.
Casino Network: Facilitates communication between the ETGTs, the leaderboard server, and the jackpot server, ensuring real-time updates and synchronization of points and rankings.
Players A, B, and C: Compete in various games to earn points and climb the leaderboard. Player rankings determine their eligibility for or share of the jackpot.
Game Logic Processor: Tracks player performance and awards points based on predefined criteria, such as winning hands, successful bets, or rare game outcomes.

### Implementation Details:

To implement this system, the ETGTs are integrated with the tournament leaderboard, which tracks player performance in real time.
1. Leaderboard Point System: Players earn points for various in-game achievements, such as winning a hand, making strategic bets, or hitting rare game outcomes. These points are added to the tournament leaderboard, which is visible on each player's ETGT.
2. Real-Time Leaderboard Updates: The leaderboard server tracks player performance across all participating DETGs, updating the rankings in real time. Players may see their position on the leaderboard and their progress toward qualifying for the jackpot.
3. Jackpot Distribution Based on Rankings: When the jackpot is triggered, the system awards the prize based on leaderboard rankings. The top-ranking players receive a larger share of the jackpot, while lower-ranking players may receive smaller payouts or no payout at all.
4. Competitive Incentive: Players are incentivized to improve their performance and climb the leaderboard, as higher rankings lead to better chances of winning the jackpot or receiving a larger payout.

### Example Walk-Through Scenario:

1. Player A, Player B, and Player C are competing in different games (e.g., blackjack, baccarat, and roulette) and earning points based on their performance. Player A wins several hands of blackjack, climbing to the top of the leaderboard, while Player B earns fewer points and remains in a lower position.
2. The system displays the real-time leaderboard on each player's ETGT, showing their current ranking and total points.
3. When the jackpot is triggered by an event in Player C's game, the system distributes the jackpot based on the leaderboard rankings. Player A, being at the top of the leaderboard, receives the largest share of the jackpot, while Player B receives a smaller portion based on their lower ranking.

### Player Interaction:

Players interact with the system by competing in DETG games to earn points and climb the leaderboard. The leaderboard adds a competitive element to the gameplay, encouraging players to perform well and improve their rankings. As players progress up the leaderboard, their chances of winning the jackpot or receiving a larger payout increase, adding excitement and motivation to the game.

### Distinguishing Innovative Concepts:

This concept is unique because it links the jackpot to a tournament-style leaderboard, where player performance directly affects their eligibility and share of the prize. This competitive structure contrasts with traditional jackpot systems, where prizes are typically awarded based on chance or random triggers. By tying the jackpot to player rankings, the system adds a skill-based element to the gameplay, rewarding top performers with larger payouts.

### Distinguishing Inventive Steps:

1. Leaderboard-Linked Jackpot: Players earn points and climb a tournament leaderboard, with their ranking determining their eligibility for the jackpot or share of the prize.
2. Real-Time Ranking Updates: The leaderboard is updated in real time, providing players with immediate feedback on their performance and encouraging competitive gameplay.
3. Performance-Based Jackpot Distribution: The jackpot is distributed based on leaderboard rankings, rewarding top-performing players with larger portions of the prize.

### 35 USC 101 Considerations:

This innovative concept is patentable because it introduces a non-abstract, performance-based improvement to jackpot systems in DETG platforms. By linking the jackpot to a tournament leaderboard, the system encourages competitive gameplay and rewards skill and strategy, providing a practical improvement in the way jackpots are managed and distributed. This system offers a tangible benefit by enhancing player engagement and creating a more dynamic and competitive gaming environment.

### Data Input:

Players input their bets and participate in DETG games, with the system tracking their performance and awarding points based on predefined criteria. These points are used to update the tournament leaderboard in real time.

### Component Interactions and Procedural Steps:

1. Players A, B, and C earn points based on their game performance, climbing the leaderboard as they achieve in-game objectives.
2. The leaderboard server tracks points and rankings, updating the leaderboard in real time and displaying the rankings on each player's ETGT.
3. When the jackpot is triggered, the system distributes the prize based on the leaderboard rankings, with top-ranking players receiving larger shares.

### Data Processing:

The system processes player performance data, awarding points based on game outcomes and updating the leaderboard in real time. When the jackpot is triggered, the system uses the leaderboard rankings to determine how the prize is distributed.

### Outputs and Responses:

Players receive real-time updates on their leaderboard rankings, along with notifications of their progress toward the jackpot. When the jackpot is triggered, the system displays the payout distribution based on the leaderboard standings.

### Data Storage and Reporting:

The system stores data on player performance, leaderboard rankings, and jackpot distributions. This data may be used for reporting and analysis, allowing casinos to evaluate player engagement and optimize the leaderboard-linked jackpot system.

### Error Handling and Security Measures:

The system includes safeguards to ensure that leaderboard rankings are calculated accurately and that jackpot payouts are distributed fairly. Security protocols prevent tampering with the leaderboard data or jackpot distribution.

### End of Interaction:

Once the jackpot is distributed based on the leaderboard rankings, the system resets the leaderboard for the next tournament cycle. Players may continue competing in future tournaments to improve their rankings and qualify for the next jackpot.

### Innovative Concept 102-Dynamic Jackpot Pool Adjustment Based on Player Activity

### Identification of Concept:

This innovative concept introduces Dynamic Jackpot Pool Adjustment Based on Player Activity in DETG (Dealer-controlled Electronic Table Games) systems, where the size of the jackpot pool fluctuates in real time based on the number of active players and their betting behaviors. The system is designed to respond to fluctuations in player participation by adjusting the jackpot pool dynamically. As more players join and place bets, the jackpot pool grows at an accelerated rate, conversely, when fewer players are active, the pool may grow more slowly or be reduced.

This feature creates a more interactive and engaging environment, as players may directly influence the size and growth of the jackpot through their activity. The dynamic adjustments also ensure that the jackpot remains relevant and appropriately sized to the current player base, avoiding scenarios where a disproportionately large or small jackpot pool impacts player excitement.

### Sequence Diagram Components:

The components involved in this system include:
ETGTs: Players place bets on their terminals, contributing to the jackpot pool. The system monitors player activity, such as the number of active players and their bet sizes, and adjusts the jackpot growth rate accordingly.
Player Activity Tracker: A module that tracks the number of active players and their bet sizes in real time. This tracker communicates with the jackpot server to determine dynamic adjustments based on player activity.
Jackpot Server: Manages the overall jackpot pool and adjusts its growth rate based on the data provided by the player activity tracker. The server ensures that the jackpot pool grows proportionally to player activity.
Casino Network: Facilitates real-time communication between the ETGTs, player activity tracker, and the jackpot server, ensuring that adjustments are applied in real time.
Players A, B, and C: Players contribute to the jackpot pool through their gameplay, with their activity influencing the growth rate of the pool.
Game Logic Processor: Monitors game outcomes and tracks player contributions, feeding this data into the dynamic jackpot adjustment process.

### Implementation Details:

To implement dynamic jackpot pool adjustment, the system tracks player activity and uses predefined rules to adjust the jackpot's growth rate based on the number of active players and the size of their contributions.
1. Player Activity Monitoring: The system continuously monitors the number of active players and their bet sizes. This data is fed into the player activity tracker, which determines how the jackpot pool should adjust in response to current player participation.
2. Dynamic Growth Adjustments: The jackpot server adjusts the growth rate of the jackpot pool based on the player activity data. For example, if a large number of players are active and placing high-value bets, the pool may grow faster. Conversely, if fewer players are active or betting lower amounts, the growth rate may slow or even temporarily reduce.
3. Real-Time Updates: As players join or leave the game and adjust their bet sizes, the system dynamically updates the jackpot pool in real time. Players may see the impact of their contributions and activity on the pool's growth, encouraging more engagement.
4. Player Notifications: The system may notify players of significant changes to the jackpot pool, such as rapid growth during peak activity or a slowdown during quieter periods, increasing player awareness and interaction.

### Example Walk-Through Scenario:

1. Player A, Player B, and Player C are all actively participating in different DETGs (e.g., blackjack, roulette, baccarat). The player activity tracker notes that all three players are placing high bets, leading the jackpot server to increase the growth rate of the pool.
2. As the number of active players increases, the jackpot pool grows faster, prompting Player D to join, further accelerating the jackpot growth.
3. Later, when Player A and Player B leave the game, the system slows down the growth rate of the jackpot pool to reflect the reduced player activity.

### Player Interaction:

Players influence the growth of the jackpot pool through their activity and betting behavior. The more active players and higher bets placed, the faster the pool grows, providing an incentive for players to remain engaged and place larger bets. This dynamic system makes players feel more connected to the jackpot's progression, as their actions directly impact its size.

### Distinguishing Innovative Concepts:

This concept is unique because it introduces real-time, dynamic adjustments to the jackpot pool based on player activity. Unlike traditional jackpot systems that rely on fixed contribution rates, this system responds to fluctuations in the player base and betting patterns, ensuring that the jackpot remains proportionate to the current level of participation. This approach creates a more engaging and interactive experience, as players may see how their actions influence the pool's growth.

### Distinguishing Inventive Steps:

1. Dynamic Growth Adjustments Based on Player Activity: The jackpot pool adjusts in real time based on the number of active players and their bet sizes, creating a fluid and responsive system.
2. Real-Time Player Engagement: Players may see the direct impact of their actions on the jackpot pool, encouraging more active participation and higher bets.
3. Scalable Jackpot Management: The system ensures that the jackpot pool remains relevant to the current player base, growing more quickly during peak times and slowing down during off-peak periods.

### 35 USC 101 Considerations:

This innovative concept is patentable under 35 USC 101 as it introduces a novel method of dynamically adjusting the jackpot pool in response to player activity, providing a tangible improvement to DETG systems. The real-time tracking and adjustment of the jackpot pool based on player engagement offer a practical application that enhances the gaming experience and ensures that jackpots are proportionate to current player activity. This system represents a significant improvement over conventional static jackpot systems.

### Data Input:

Players input their bets, and the system tracks the number of active players and the value of their contributions. This data is used to adjust the growth rate of the jackpot pool in real time.

### Component Interactions and Procedural Steps:

1. Players A, B, and C place bets, contributing to the jackpot pool. The player activity tracker monitors the number of active players and the size of their bets.
2. The jackpot server adjusts the pool's growth rate based on the data from the player activity tracker, ensuring that the jackpot grows proportionally to current player activity.
3. Real-time updates are displayed on the ETGTs, showing players the dynamic changes to the jackpot pool.

### Data Processing:

The system processes player activity data, tracking the number of active players and the size of their contributions. The jackpot server uses this data to dynamically adjust the pool's growth rate, ensuring that it reflects the current level of participation.

### Outputs and Responses:

Players receive real-time updates on the jackpot pool's growth, with notifications of significant changes due to fluctuations in player activity. The system displays the adjusted pool size and growth rate on each player's ETGT.

### Data Storage and Reporting:

The system stores data on player activity, jackpot growth rates, and adjustments based on participation levels. This information may be used for reporting and analysis, allowing casinos to optimize the dynamic jackpot system.

### Error Handling and Security Measures:

The system includes safeguards to ensure that player activity is accurately tracked and that the jackpot pool is adjusted fairly based on real-time data. Security protocols prevent tampering with player contributions or jackpot adjustments, ensuring transparency and fairness.

### End of Interaction:

Once the jackpot is triggered, the system resets the player activity tracker and jackpot pool for the next round. Players may continue contributing to future jackpots, with their activity influencing the pool's growth in real time.

Innovative Concept 103—Player-Triggered Mini Jackpots within Main Jackpot System

### Identification of Concept:

This innovative concept introduces Player-Triggered Mini Jackpots Within Main Jackpot System in DETG systems, where players may trigger smaller “mini jackpots” independently of the main jackpot. The mini jackpots are designed to offer frequent, smaller payouts that keep players engaged while they work toward the larger, main jackpot. Players trigger mini jackpots by meeting certain in-game conditions, such as achieving a specific game outcome or placing a winning bet of a certain value.

These mini jackpots provide players with more immediate rewards and increase excitement by offering multiple opportunities to win during a single gaming session. The system is designed to complement the main jackpot, ensuring that players remain motivated by both small and large prize possibilities.

### Sequence Diagram Components:

The notable components involved include:
ETGTs: Players place bets and participate in DETG games, with the possibility of triggering mini jackpots based on specific in-game conditions.
Mini Jackpot Trigger Processor: A module that monitors game outcomes and determines when a player has met the criteria to trigger a mini jackpot.
Jackpot Server: Manages both the main jackpot and the mini jackpots, ensuring that payouts are distributed accordingly when either jackpot is triggered.
Casino Network: Facilitates real-time communication between the ETGTs, mini jackpot trigger processor, and the jackpot server, ensuring that mini jackpots are triggered and awarded promptly.
Players A and B: Players participate in the game and aim to trigger mini jackpots by meeting specific criteria, such as winning a certain number of hands or hitting rare game outcomes.
Game Logic Processor: Tracks in-game conditions and outcomes to determine when players have qualified for mini jackpot triggers.

### Implementation Details:

The mini jackpots are integrated into the main jackpot system, offering players additional chances to win smaller prizes during their gameplay.
1. Mini Jackpot Criteria: The system is configured with specific criteria that players must meet to trigger a mini jackpot. These criteria may include achieving a rare game outcome, placing a winning bet of a certain size, or completing a streak of consecutive wins.
2. Independent Mini Jackpot Pool: Each mini jackpot has its own prize pool, which is separate from the main jackpot. Players who trigger a mini jackpot receive an immediate payout, while their contributions to the main jackpot continue to accumulate.
3. Real-Time Mini Jackpot Triggers: As players meet the criteria for a mini jackpot, the system immediately triggers the prize and awards it to the qualifying player. This real-time reward keeps players engaged, knowing that multiple jackpot opportunities exist during their gaming session.
4. Ongoing Main Jackpot Accumulation: While mini jackpots offer more frequent payouts, players' contributions to the main jackpot pool continue. This dual system provides both immediate and long-term incentives for players to stay engaged.

### Example Walk-Through Scenario:

1. Player A is playing blackjack and places a $50 bet. They win a hand with a perfect combination of cards, triggering a mini jackpot. The system immediately awards them a $500 prize from the mini jackpot pool.
2. Player B is playing roulette and places a winning bet on a rare outcome. This also triggers a mini jackpot, and Player B receives a $300 payout.
3. Both players continue contributing to the main jackpot pool, which remains active and growing, while they enjoy the smaller mini jackpot wins.

### Player Interaction:

Players may trigger mini jackpots by achieving certain game outcomes or placing specific bets during gameplay. This system adds excitement by offering multiple opportunities to win smaller prizes in addition to the main jackpot, keeping players motivated and engaged. Players are aware that they may win mini jackpots at any time, making each game round more thrilling.

### Distinguishing Innovative Concepts:

This concept is unique because it integrates mini jackpots into the main jackpot system, allowing players to win smaller, more frequent prizes during their gaming sessions. Unlike traditional jackpot systems, which typically focus on a single large prize, this system provides multiple layers of rewards, increasing player engagement. The mini jackpots add variety and excitement to the gameplay, ensuring that players remain motivated by both short-term and long-term prize opportunities.

### Distinguishing Inventive Steps:

1. Player-Triggered Mini Jackpots: Players may trigger mini jackpots by meeting specific in-game criteria, offering frequent rewards in addition to the main jackpot.
2. Independent Mini Jackpot Pool: Each mini jackpot has its own prize pool, which is separate from the main jackpot, ensuring that players receive immediate payouts without affecting the main prize.
3. Real-Time Payouts: The system triggers and awards mini jackpots in real time, providing players with instant rewards and maintaining engagement throughout their gaming session.

### 35 USC 101 Considerations:

This innovative concept is patentable under 35 USC 101 as it introduces a novel method of integrating mini jackpots into the main jackpot system, providing a dual-layer incentive structure for players. By offering both immediate and long-term rewards, the system enhances the functionality of DETG platforms and creates a more dynamic and engaging gaming experience. The mini jackpot system offers a practical improvement over traditional jackpot structures, providing frequent payouts that keep players motivated and excited.

### Data Input:

Players input their bets and participate in DETG games. The system tracks game outcomes and determines when a mini jackpot is triggered based on predefined criteria.

### Component Interactions and Procedural Steps:

1. Players A and B place bets on their respective games, aiming to trigger mini jackpots by achieving specific in-game outcomes.
2. The mini jackpot trigger processor monitors gameplay, identifying when a player meets the criteria for a mini jackpot.
3. When a mini jackpot is triggered, the system awards the prize from the independent mini jackpot pool and updates the player's ETGT with the payout.

### Data Processing:

The system processes player inputs and game outcomes, comparing them against the predefined mini jackpot criteria. When a player qualifies for a mini jackpot, the system triggers the payout and updates the mini jackpot pool in real time.

### Outputs and Responses:

Players receive real-time notifications when they trigger a mini jackpot, with the system displaying the prize amount and updating the independent mini jackpot pool. Players may continue playing and contributing to both the mini and main jackpot pools.

### Data Storage and Reporting:

The system stores data on mini jackpot triggers, payouts, and player contributions to both the mini and main jackpot pools. This data may be used for reporting and analysis, allowing casinos to evaluate the effectiveness of the mini jackpot system.

### Error Handling and Security Measures:

The system includes safeguards to ensure that mini jackpots are triggered fairly and that payouts are distributed accurately. Security protocols prevent tampering with the mini jackpot criteria or prize pools, ensuring transparency and fairness for all players.

### End of Interaction:

Once a mini jackpot is triggered and awarded, the system resets the mini jackpot pool for the next round. Players may continue participating in both the mini and main jackpot systems, with the possibility of triggering future mini jackpots during their gameplay.

Innovative Concept 104—Jackpot Integration with Personalized Player Achievements

### Identification of Concept:

This innovative concept introduces Jackpot Integration with Personalized Player Achievements in DETG systems, where players may unlock special jackpot opportunities or increased chances of winning by completing personalized achievements during gameplay. These achievements are tailored to each player's gaming style and history, rewarding them for reaching specific milestones, such as playing a certain number of games, winning consecutive hands, or placing high-value bets.

The personalized achievement system integrates directly with the jackpot pool, providing players with unique opportunities to influence the jackpot based on their individual progress. Players are encouraged to pursue these achievements to unlock enhanced jackpot participation, creating a more engaging and personalized gaming experience.

### Sequence Diagram Components:

Notable components involved include:
ETGTs: Players receive personalized achievement goals on their terminals, which are updated based on their gameplay history and progress. These achievements offer opportunities to increase jackpot eligibility or unlock special jackpot features.
Player Achievement Tracker: A server that tracks each player's progress toward their personalized achievements, updating their ETGT in real time with new goals and milestones.
Jackpot Server: Manages the main jackpot pool and integrates with the player achievement tracker to provide players with enhanced jackpot opportunities based on their achievement progress.
Casino Network: Facilitates real-time communication between the ETGTs, player achievement tracker, and jackpot server, ensuring that achievement progress and jackpot opportunities are updated in real time.
Players A and B: Players work toward completing personalized achievements during their gameplay, unlocking enhanced jackpot participation or increased chances of winning.
Game Logic Processor: Tracks game outcomes and player behaviors, updating each player's achievement progress based on predefined criteria.

### Implementation Details:

The personalized achievement system is integrated into the DETG platform, providing players with customized goals that align with their gaming style and history.
1. Personalized Achievement Criteria: The system assigns each player a set of personalized achievement goals, such as winning a certain number of games, placing high-value bets, or achieving specific in-game outcomes. These goals are tailored to each player's past performance and preferences.
2. Achievement Tracking: The player achievement tracker monitors each player's progress toward their personalized goals, updating their ETGT in real time with their current status. As players complete achievements, they unlock special jackpot opportunities, such as increased eligibility or higher payout chances.
3. Enhanced Jackpot Integration: Players who complete achievements are granted enhanced access to the jackpot pool, such as higher chances of triggering the jackpot or unlocking exclusive jackpot tiers. This provides players with a direct incentive to pursue their personalized goals.
4. Real-Time Updates: The system continuously tracks player progress and updates their ETGT with new achievements and opportunities, ensuring that players remain engaged with their personalized goals.

### Example Walk-Through Scenario:

1. Player A is given a personalized achievement goal of winning five consecutive hands in blackjack. As they progress toward this goal, their ETGT displays real-time updates on their achievement status.
2. Player B is assigned an achievement goal of placing ten high-value bets in roulette. When Player B completes this goal, the system unlocks an exclusive jackpot opportunity, granting them a higher chance of winning the main jackpot.
3. Both players continue working toward their achievements, knowing that their progress will directly influence their participation in the jackpot system.

### Player Interaction:

Players interact with the personalized achievement system by working toward their assigned goals during gameplay. These goals are tailored to each player's individual gaming style and history, providing them with unique opportunities to enhance their participation in the jackpot pool. The system encourages players to stay engaged and pursue their achievements, knowing that completing these goals will unlock special jackpot features or increased chances of winning.

### Distinguishing Innovative Concepts:

This concept is novel because it integrates personalized player achievements directly into the jackpot system, offering players unique opportunities to influence the jackpot based on their individual progress. Unlike traditional jackpot systems, which rely on random triggers or fixed contributions, this system rewards players for their personal achievements, creating a more engaging and customized gaming experience. The personalized nature of the achievements ensures that each player's goals are aligned with their gaming preferences and history.

### Distinguishing Inventive Steps:

1. Personalized Achievement Goals: Players receive customized achievement goals based on their gameplay history, offering unique opportunities to enhance their participation in the jackpot pool.
2. Direct Integration with Jackpot System: Completing achievements unlocks special jackpot opportunities, such as increased eligibility or higher payout chances, linking player progress to jackpot outcomes.
3. Real-Time Achievement Tracking: The system tracks each player's progress toward their personalized goals in real time, providing continuous updates and encouragement to pursue their achievements.

### 35 USC 101 Considerations:

This innovative concept is patentable under 35 USC 101 as it introduces a specific, non-abstract improvement to jackpot systems by integrating personalized player achievements. By linking individual player progress to jackpot opportunities, the system provides a practical application that enhances player engagement and creates a more dynamic and interactive gaming experience. This system offers a tangible improvement over traditional jackpot structures by rewarding players for their personal achievements and providing customized goals that influence jackpot outcomes.

### Data Input:

Players input their bets and participate in DETG games. The system tracks their gameplay outcomes and behaviors, using this data to update their personalized achievement progress and unlock special jackpot opportunities.

### Component Interactions and Procedural Steps:

1. Players A and B work toward their personalized achievement goals, completing specific in-game tasks to unlock enhanced jackpot participation.
2. The player achievement tracker tracks their progress in real time, updating their ETGTs with notifications about their current achievement status and what steps remain for them to unlock special jackpot opportunities.
3. As players complete their achievements, the system sends this information to the jackpot server, which adjusts the players' eligibility for enhanced jackpot opportunities, such as increased chances of triggering the jackpot or unlocking exclusive payout tiers.

### Data Processing:

The system processes player data, including bets placed, game outcomes, and in-game actions, to determine when a player has achieved their personalized goals. Once a goal is completed, the player achievement tracker communicates with the jackpot server to update the player's eligibility for jackpot-related benefits.

### Outputs and Responses:

Players receive real-time notifications on their ETGTs, informing them of their progress toward completing achievements and any special jackpot opportunities unlocked as a result. The system provides continuous feedback to players about their status, making the experience interactive and encouraging further engagement.

### Data Storage and Reporting:

The system stores data related to each player's achievements, progress toward goals, and any jackpot opportunities unlocked. This data may be used for reporting and analysis, allowing casinos to evaluate how the personalized achievement system impacts player engagement and overall gameplay dynamics.

### Error Handling and Security Measures:

The system includes error-checking mechanisms to ensure that players' achievements are accurately tracked and that rewards are properly assigned. Security protocols prevent tampering with achievement progress or jackpot eligibility, ensuring fairness and transparency in the gameplay experience.

### End of Interaction:

Once a player completes their achievements and receives any related jackpot benefits, the system resets their achievement tracker for the next cycle of goals. Players may continue participating in future games, where new personalized achievements will be generated, maintaining engagement and offering ongoing incentives to unlock further jackpot opportunities.

### Innovative Concept 105—Jackpot Distribution Through Social Collaboration

### Identification of Concept:

This innovative concept introduces Jackpot Distribution Through Social Collaboration in DETG systems, where players may form groups or “teams” to collaborate on triggering and sharing a jackpot. The system allows players to pool their contributions and work together toward common gameplay goals, such as achieving specific outcomes or placing bets that collectively trigger the jackpot. Once triggered, the jackpot is distributed among all team members based on their individual contributions or participation levels.

The social collaboration element encourages cooperative gameplay, where players not only compete against the house but also collaborate with each other to increase their chances of winning the jackpot. This adds a layer of social interaction and strategy, as players must coordinate their efforts to achieve collective goals and share in the jackpot reward.

### Sequence Diagram Components:

Notable components involved include:
ETGTs: Players may join or create teams through their individual terminals. The system tracks their contributions and group progress toward triggering the jackpot.
Team Collaboration Module: A server or software component that facilitates team formation, tracks team progress, and ensures that the jackpot contributions are pooled and distributed accordingly when the team wins.
Jackpot Server: Manages the overall jackpot pool, tracking team contributions and distributing the prize among team members once the jackpot is triggered.
Casino Network: Facilitates communication between the ETGTs, team collaboration module, and the jackpot server, ensuring that player contributions are pooled in real time and that the jackpot is distributed fairly among team members.
Players A, B, and C: Team members who collaborate toward triggering the jackpot. Each player's contribution and participation level are tracked to determine their share of the prize.
Game Logic Processor: Monitors in-game actions, contributions, and outcomes to track the team's progress toward triggering the jackpot.

### Implementation Details:

To implement this system, the ETGTs are equipped with the functionality to allow players to form teams and pool their contributions toward a shared jackpot.
1. Team Formation and Contribution Pooling: Players may form teams by inviting others to join or by joining an existing team. Once a team is formed, the system pools their individual contributions to the jackpot pool, creating a collective fund.
2. Team Progress Tracking: The team collaboration module tracks the team's overall progress toward triggering the jackpot, as well as each member's contributions. Teams may set shared goals, such as achieving certain game outcomes or placing bets of a specific size.
3. Jackpot Triggering and Distribution: When the team meets the predefined criteria for triggering the jackpot, the jackpot server awards the prize to the team. The system then distributes the jackpot among the team members based on each player's contribution or participation level.
4. Real-Time Collaboration Feedback: Players receive updates on their team's progress in real time, including notifications about pooled contributions, shared goals, and the likelihood of triggering the jackpot.

### Example Walk-Through Scenario:

1. Player A, Player B, and Player C form a team while playing baccarat and blackjack on their respective ETGTs. The system tracks their individual contributions to the jackpot pool and pools them together into a collective fund.
2. The team sets a shared goal of placing high-value bets for a series of rounds. As they meet these goals, their progress toward triggering the jackpot is displayed on their ETGTs.
3. When the team achieves a collective rare outcome-such as hitting consecutive wins across all team members—the system triggers the jackpot, and the prize is distributed among the team members based on their individual contributions to the pool.

### Player Interaction:

Players interact with the social collaboration system by joining or forming teams, pooling their contributions to the jackpot, and working toward shared goals. The collaborative element adds excitement and strategy to the game, as players must coordinate their efforts to maximize their chances of triggering the jackpot. The shared experience encourages social interaction and increases engagement, as players feel a sense of teamwork and accomplishment when the jackpot is won.

### Distinguishing Innovative Concepts:

This concept is distinct because it introduces social collaboration into the jackpot system, where players work together to trigger and share a collective prize. Unlike traditional jackpot systems that focus on individual contributions, this system fosters cooperative gameplay, where players collaborate toward a common goal and share in the rewards. This approach enhances the social aspect of gaming, encouraging teamwork and increasing player engagement.

### Distinguishing Inventive Steps:

1. Team-Based Jackpot Contribution Pooling: Players may pool their contributions with teammates, collectively working toward triggering the jackpot and sharing the prize.
2. Real-Time Team Progress Tracking: The system tracks each team's progress toward shared goals and updates members in real time, encouraging collaboration and coordinated gameplay.
3. Collaborative Jackpot Distribution: When the jackpot is triggered, the prize is distributed among team members based on their individual contributions or participation levels, adding a social and strategic dimension to the jackpot system.

### 35 USC 101 Considerations:

This innovative concept is patentable because it introduces a novel, non-abstract method of integrating social collaboration into jackpot systems. By allowing players to form teams and pool their contributions toward a shared jackpot, the system provides a practical application that enhances the gaming experience through cooperative gameplay. The social collaboration feature represents a significant improvement over traditional jackpot systems, creating a more interactive and engaging environment that encourages teamwork and social interaction.

### Data Input:

Players input their bets and participate in DETG games as part of a team. The system tracks each player's contributions, participation levels, and in-game actions to determine progress toward the team's collective goals.

Component Interactions and Procedural Steps:
1. Players A, B, and C form a team and contribute to the jackpot pool through their respective games. The team collaboration module tracks their contributions and progress toward triggering the jackpot.
2. The team works toward shared goals, such as placing high-value bets or achieving certain game outcomes, with their progress displayed in real time on their ETGTs.
3. When the jackpot is triggered, the system distributes the prize among the team members based on their individual contributions or participation levels.

### Data Processing:

The system processes player contributions and in-game actions, tracking team progress toward collective goals. When the team meets the criteria for triggering the jackpot, the system calculates each member's share of the prize based on their contributions to the pool.

### Outputs and Responses:

Players receive real-time updates on their team's progress, including notifications about pooled contributions, progress toward shared goals, and the likelihood of triggering the jackpot. When the jackpot is triggered, the system displays the distribution of the prize among team members.

### Data Storage and Reporting:

The system stores data on team formation, contributions, progress toward shared goals, and jackpot triggers. This data may be used for reporting and analysis, allowing casinos to evaluate the effectiveness of the social collaboration system and its impact on player engagement.

### Error Handling and Security Measures:

The system includes safeguards to ensure that contributions are accurately pooled and that jackpot payouts are distributed fairly among team members. Security protocols prevent tampering with team progress or contribution data, ensuring transparency and fairness for all players.

### End of Interaction:

Once the jackpot is distributed, the system resets the team's contribution pool and progress toward the next round of gameplay. Players may continue forming teams and collaborating in future sessions, working toward new shared goals and jackpot opportunities.

### Innovative Concept 106—Skill-Based Jackpot Multiplier

### Identification of Concept:

This innovative concept introduces a Skill-Based Jackpot Multiplier in DETG systems, where players may increase their potential jackpot payout based on their performance and skill level in the game. The system rewards players for demonstrating advanced gameplay skills, such as making strategic bets, winning consecutive hands, or achieving rare game outcomes. As players meet these skill-based criteria, the system applies a multiplier to their contributions or increases their chances of winning a larger share of the jackpot.

This feature appeals to competitive players who enjoy games of skill, as it offers them an opportunity to leverage their abilities to increase their potential rewards. The skill-based multiplier provides an additional incentive for players to focus on improving their gameplay, creating a more engaging and dynamic experience.

### Sequence Diagram Components:

Notable components involved include:
ETGTs: Players participate in games that allow them to unlock skill-based multipliers through advanced gameplay actions. The system tracks their performance and applies the multiplier to their contributions or jackpot eligibility.
Skill Tracking Module: A server that monitors each player's in-game actions, tracking their performance and determining when they qualify for skill-based multipliers.
Jackpot Server: Manages the jackpot pool and applies the skill-based multipliers to players' contributions or jackpot chances, ensuring that skilled players are rewarded accordingly.
Casino Network: Facilitates communication between the ETGTs, skill tracking module, and jackpot server, ensuring that player performance data is processed in real time and multipliers are applied correctly.
Players A and B: Players may unlock skill-based multipliers by demonstrating superior gameplay skills, increasing their chances of winning a larger share of the jackpot.
Game Logic Processor: Tracks in-game actions, such as strategic bets, winning streaks, or rare game outcomes, and communicates with the skill tracking module to apply the multiplier.

### Implementation Details:

To implement this concept, the system tracks each player's gameplay actions and applies a multiplier based on their performance.
1. Skill-Based Criteria: The system defines a set of skill-based criteria that players must meet to unlock a jackpot multiplier. These criteria may include achieving consecutive wins, making strategic bets, or reaching high-value game outcomes.
2. Multiplier Application: When a player meets the skill-based criteria, the system applies a multiplier to their contributions or their chance of winning the jackpot. For example, a player who wins five consecutive blackjack hands may have their jackpot contribution doubled.
3. Real-Time Skill Tracking: The skill tracking module monitors each player's in-game actions and determines when they qualify for a multiplier. This data is communicated to the jackpot server, which adjusts the player's potential payout accordingly.
4. Enhanced Jackpot Rewards: Players who demonstrate advanced gameplay skills are rewarded with larger shares of the jackpot or increased chances of triggering the prize, providing a tangible incentive to improve their performance.

### Example Walk-Through Scenario:

1. Player A is playing blackjack and wins five consecutive hands. The system recognizes this achievement and applies a 2× multiplier to Player A's contributions to the jackpot pool.
2. Player B is playing baccarat and places a series of strategic bets, accurately predicting the outcomes of several rounds. This skill-based performance unlocks a 3× multiplier, increasing Player B's chances of triggering the jackpot.
3. Both players continue to play with their multipliers in effect, knowing that their advanced gameplay skills have increased their potential rewards.

### Player Interaction:

Players interact with the system by demonstrating advanced gameplay skills, such as making strategic decisions or achieving rare game outcomes. The skill-based multiplier adds an element of competitiveness to the game, encouraging players to focus on improving their performance to unlock larger potential payouts. The system rewards skilled players with enhanced jackpot opportunities, making the experience more engaging and rewarding.

### Distinguishing Innovative Concepts:

This concept is distinct because it introduces a skill-based multiplier that directly influences a player's contributions to the jackpot or their chances of winning. Unlike traditional jackpot systems, where payouts are typically based on random outcomes or fixed contributions, this system rewards players for their skill and performance, creating a more dynamic and interactive gaming experience. The skill-based multiplier provides an incentive for players to improve their gameplay, differentiating this system from chance-based jackpots.

### Distinguishing Inventive Steps:

1. Skill-Based Multiplier Application: Players may unlock multipliers based on their in-game performance, increasing their contributions to the jackpot pool or their chances of winning.
2. Real-Time Performance Tracking: The system tracks each player's gameplay actions in real time, applying the multiplier as soon as the player meets the skill-based criteria.
3. Enhanced Payout Opportunities for Skilled Players: Players who demonstrate advanced skills are rewarded with larger potential payouts, making the jackpot system more competitive and engaging.

### 35 USC 101 Considerations:

This innovative concept is patentable because it introduces a novel method of applying skill-based multipliers to jackpot systems in DETG platforms. By rewarding players for their gameplay skills, the system offers a practical application that enhances the gaming experience and provides a tangible incentive for players to improve their performance. The skill-based multiplier represents a significant improvement over traditional chance-based jackpot systems, adding a layer of strategy and competitiveness.

### Data Input:

Players input their bets and participate in DETG games. The system tracks their in-game actions, such as consecutive wins or strategic bets, to determine when they qualify for a skill-based multiplier.

### Component Interactions and Procedural Steps:

1. Players A and B demonstrate advanced gameplay skills, such as winning consecutive hands or making strategic bets.
2. The skill tracking module monitors their performance and applies the appropriate multiplier to their contributions or jackpot eligibility.
   3. The jackpot server adjusts the players' chances of winning or the size of their potential payout based on the applied multipliers.

### Data Processing:

The system processes player performance data, tracking in-game actions that qualify for a skill-based multiplier. The multiplier is applied to the player's jackpot contributions or chances of winning, and the jackpot server updates the player's potential payout accordingly.

### Outputs and Responses:

Players receive real-time feedback on their progress toward unlocking skill-based multipliers. The system displays notifications on their ETGTs when a multiplier is applied, informing them of their enhanced chances of winning the jackpot or increased contribution size.

### Data Storage and Reporting:

The system stores data on player performance, skill-based multiplier triggers, and jackpot contributions. This data may be used for reporting and analysis, allowing casinos to evaluate how the skill-based multiplier system affects player engagement and gameplay dynamics.

### Error Handling and Security Measures:

The system includes safeguards to ensure that skill-based multipliers are applied fairly and accurately. Security protocols prevent tampering with performance data or multiplier applications, ensuring transparency and fairness for all players.

### End of Interaction:

Once a player's game session ends or the jackpot is triggered, the system resets the player's skill-based multiplier for future gameplay. Players may continue demonstrating their skills in future sessions, unlocking new multipliers and increasing their chances of winning larger prizes.

### Innovative Concept 107-Jackpot Growth Based on Casino Event Participation

### Identification of Concept:

This innovative concept introduces Jackpot Growth Based on Casino Event Participation in DETG systems, where the size of the jackpot pool dynamically increases based on player participation in special casino events or promotions. These events may include holiday-themed promotions, tournaments, or time-limited challenges, encouraging players to participate in specific games or activities. When players engage in these events, their contributions to the jackpot pool are amplified, leading to accelerated jackpot growth.

By linking the jackpot pool to casino-wide events, the system promotes higher engagement during promotional periods, incentivizing players to participate in special events to boost the jackpot. The more players engage with the event, the faster the jackpot grows, creating excitement and urgency for players to get involved.

### Sequence Diagram Components:

Notable components involved in this system include:
ETGTs: Players participate in event-specific DETG games that are linked to the special promotion. Contributions made during these event periods are amplified and contribute to the accelerated growth of the jackpot pool.
Event Participation Module: A server or software component that tracks player involvement in casino events and adjusts their contributions to the jackpot based on their participation level.
Jackpot Server: Manages the overall jackpot pool and dynamically increases its growth based on the number of players participating in the event and the size of their bets.
Casino Network: Facilitates real-time communication between the ETGTs, event participation module, and the jackpot server, ensuring that the event-based contributions are tracked and applied to the jackpot pool.
Players A, B, and C: Participants in casino events who engage with the DETG games, making contributions to the jackpot pool that are amplified based on the event rules.
Game Logic Processor: Monitors game outcomes, bet sizes, and player participation during the event to determine how much their contributions are amplified for the jackpot.

### Implementation Details:

To implement jackpot growth based on casino event participation, the system must integrate event-specific tracking and contribution adjustments.

1. Event Configuration: The casino sets up special events or promotions, such as tournaments, seasonal challenges, or holiday-themed games. Players who participate in these events have their contributions to the jackpot pool amplified by a predefined multiplier (e.g., 2× or 3× contributions during a holiday event).
2. Real-Time Contribution Amplification: When players participate in event-related games, their contributions to the jackpot pool are adjusted based on the event's rules. For instance, a player's contribution during a holiday event may be doubled, leading to faster jackpot growth.
3. Event Participation Tracking: The event participation module tracks which players are participating in the event and adjusts their contributions accordingly. The system ensures that players are aware of the event and its impact on the jackpot growth, encouraging more engagement.
4. Dynamic Jackpot Updates: As more players participate in the event and place bets, the jackpot pool grows dynamically in real time. Players may see the rapid growth of the jackpot, driven by the special event contributions, creating excitement and urgency to continue playing.

### Example Walk-Through Scenario:

1. Player A, Player B, and Player C participate in a casino-wide holiday event, where contributions to the jackpot pool are doubled during the event period. Player A plays a blackjack game, contributing $10 to the jackpot, which is amplified to $20 due to the event.
2. As the event progresses, more players join, leading to accelerated growth in the jackpot pool. Player B participates in a baccarat game and contributes $15, which is also doubled to $30.
3. By the end of the event, the jackpot pool has grown significantly faster than during regular gameplay, and players are excited to see the prize potential increase due to their event participation.

### Player Interaction:

Players interact with the jackpot system by participating in special casino events and placing bets during the event period. Their contributions to the jackpot are amplified based on the event rules, leading to faster jackpot growth. The system creates excitement and motivation for players to engage with these events, knowing that their participation will significantly boost the jackpot pool.

### Distinguishing Innovative Concepts:

This concept is unique because it links jackpot growth to casino-wide events, allowing players to influence the size of the jackpot pool through their participation in promotions or special challenges. Unlike traditional jackpot systems where contributions are fixed, this system dynamically adjusts player contributions based on their event participation, providing an additional layer of excitement and engagement. This approach drives player activity during promotional periods and enhances the overall gaming experience by creating event-driven opportunities for accelerated jackpot growth.

### Distinguishing Inventive Steps:

1. Event-Based Jackpot Amplification: The system increases player contributions to the jackpot pool during special events, leading to faster growth and heightened excitement.
2. Real-Time Contribution Adjustments: Player participation in casino events is tracked in real time, and their contributions are adjusted dynamically based on event rules, ensuring that the jackpot grows rapidly during promotional periods.
3. Event-Driven Player Engagement: The system encourages players to engage with special casino events, knowing that their participation will significantly impact the size of the jackpot pool.

### 35 USC 101 Considerations:

This innovative concept is patentable because it introduces a novel method of linking jackpot growth to casino events and promotions, providing a practical application that enhances player engagement and interaction with the game. By dynamically adjusting player contributions based on event participation, the system creates a unique and event-driven gaming experience that drives higher levels of involvement and offers tangible benefits to players. The system represents a significant improvement over traditional static jackpot growth mechanisms.

### Data Input:

Players input their bets and participate in event-specific DETG games. The system tracks player participation, bet sizes, and game outcomes during the event, adjusting their contributions to the jackpot pool accordingly.

### Component Interactions and Procedural Steps:

1. Players A, B, and C participate in the event, placing bets on their respective games. The event participation module tracks their involvement and adjusts their contributions based on the event's multiplier.
2. The system dynamically adjusts the jackpot pool, amplifying player contributions according to the event rules and displaying the rapid growth of the jackpot in real time.
3. Players are notified of the amplified contributions and the impact of their participation on the jackpot pool, creating excitement and motivating continued engagement.

### Data Processing:

The system processes player contributions, game outcomes, and event participation data to determine the amplified contribution amount for each player. The jackpot server adjusts the pool dynamically based on these contributions, ensuring that the jackpot grows faster during the event.

### Outputs and Responses:

Players receive real-time notifications of their contribution impact on the jackpot pool, with the system displaying the amplified growth rate due to their participation in the event. The system continuously updates the jackpot pool as more players join the event and place bets.

### Data Storage and Reporting:

The system stores data on player participation, event-based contributions, and the impact on the jackpot pool. This data may be used for reporting and analysis, allowing casinos to evaluate the effectiveness of the event-based jackpot system and its influence on player engagement.

### Error Handling and Security Measures:

The system includes safeguards to ensure that event-based contributions are accurately tracked and amplified based on predefined rules. Security protocols prevent tampering with player contributions or event data, ensuring transparency and fairness for all participants.

### End of Interaction:

Once the event concludes, the system resets the amplified contribution multiplier, returning the jackpot pool to its regular growth rate. Players may continue contributing to the jackpot through regular gameplay, with the event-driven boost providing a temporary, exciting opportunity for rapid jackpot growth.

### Innovative Concept 108—Progressive Mystery Jackpot Reveal Mechanism

### Identification of Concept:

This innovative concept introduces a Progressive Mystery Jackpot Reveal Mechanism in DETG systems, where the mystery jackpot amount is gradually revealed to players over time or based on certain gameplay actions. Unlike traditional mystery jackpots that remain hidden until triggered, this system offers a partial or progressive reveal of the jackpot value, building anticipation and excitement. Players may see portions of the jackpot amount unveiled as they place bets or meet specific gameplay milestones, encouraging continued participation and engagement.

The mystery jackpot reveal mechanism adds an element of suspense and motivation for players, as they strive to uncover the full value of the jackpot before it is triggered. This feature keeps players invested in the game, knowing that the more they play, the more they will learn about the hidden jackpot prize.

### Sequence Diagram Components:

Notable components involved include:
ETGTs: Players place bets and interact with the progressive reveal system through their terminals. As they play, the system reveals portions of the mystery jackpot value based on their contributions or in-game actions.
Mystery Jackpot Reveal Module: A server or software component that controls the progressive reveal of the jackpot amount. It tracks player activity and gradually unveils portions of the jackpot as players meet certain conditions.
Jackpot Server: Manages the mystery jackpot pool and determines the overall prize value, which is progressively revealed to players.
Casino Network: Facilitates real-time communication between the ETGTs, the mystery jackpot reveal module, and the jackpot server, ensuring that players' progress toward revealing the jackpot is updated in real time.
Players A, B, and C: Players participate in DETG games, with their gameplay actions influencing the gradual reveal of the mystery jackpot amount. The more they play, the more they uncover about the jackpot prize.
Game Logic Processor: Tracks player actions, such as bet sizes, game outcomes, and gameplay milestones, to determine when portions of the mystery jackpot should be revealed.

### Implementation Details:

The progressive mystery jackpot reveal mechanism is integrated into the DETG platform, offering players glimpses of the jackpot value as they progress through their gameplay.
1. Mystery Jackpot Configuration: The system assigns a mystery jackpot value, which is hidden from players at the start of gameplay. As players place bets and meet specific milestones, the system reveals portions of the jackpot value, increasing excitement and anticipation.
2. Progressive Reveal Based on Milestones: Players unlock portions of the jackpot through gameplay actions, such as placing high-value bets, winning consecutive rounds, or reaching certain gameplay milestones. The more they play, the more of the jackpot value is revealed to them.
3. Real-Time Jackpot Unveiling: The mystery jackpot reveal module updates each player's ETGT in real time, showing the progressively revealed jackpot value as they continue to play. This encourages players to keep playing in order to uncover the full prize.
4. Jackpot Trigger and Full Reveal: Once the jackpot is triggered, the full prize is revealed to the winning player. Other players who contributed to the progressive reveal experience the excitement of seeing the full jackpot value unveiled.

### Example Walk-Through Scenario:

1. Player A begins playing a roulette game with a mystery jackpot that starts as completely hidden. As Player A places bets, small portions of the jackpot value are revealed on their ETGT, showing that the total prize is growing.
2. Player B places higher bets in a blackjack game, unlocking larger portions of the mystery jackpot. The system displays the partially revealed jackpot value, motivating Player B to continue playing to reveal more of the hidden prize.
3. As both players progress through their games, they reveal increasing portions of the jackpot. When Player C triggers the jackpot with a rare outcome in baccarat, the full jackpot value is revealed to all players, and Player C wins the prize.

### Player Interaction:

Players interact with the mystery jackpot system by placing bets and progressing through gameplay. As they meet certain milestones or achieve specific outcomes, the system progressively reveals portions of the mystery jackpot value. This element of suspense and gradual unveiling keeps players engaged, as they are motivated to play more to uncover the full jackpot prize. The reveal mechanism adds excitement, as players eagerly anticipate seeing the full jackpot amount.

### Distinguishing Innovative Concepts:

This concept is novel because it introduces a progressive reveal mechanism for mystery jackpots, offering players a glimpse of the prize value as they play. Unlike traditional mystery jackpots that remain hidden until triggered, this system gradually unveils the jackpot amount, creating anticipation and excitement throughout the gameplay. The progressive reveal adds a layer of strategy and motivation, encouraging players to stay engaged as they work toward uncovering the full prize.

### Distinguishing Inventive Steps:

1. Progressive Jackpot Reveal: The system gradually reveals portions of the mystery jackpot value based on player actions, building anticipation and encouraging continued gameplay.
2. Real-Time Unveiling of Hidden Prizes: Players receive real-time updates on the revealed portions of the jackpot, creating a dynamic and interactive experience that keeps them engaged.
3. Milestone-Based Unlocking: Players unlock portions of the mystery jackpot by meeting specific gameplay milestones, such as placing high-value bets or winning consecutive rounds, adding an element of strategy and reward.

### 35 USC 101 Considerations:

This innovative concept is patentable because it introduces a novel method of progressively revealing mystery jackpots based on player actions. By offering a dynamic and interactive reveal process, the system enhances the gaming experience and provides a tangible incentive for players to stay engaged and continue playing. The progressive reveal mechanism represents a significant improvement over traditional mystery jackpots, offering a practical application that builds excitement and anticipation throughout the gameplay.

### Data Input:

Players input their bets and participate in DETG games. The system tracks their actions, such as bet sizes, game outcomes, and gameplay milestones, to determine when portions of the mystery jackpot value should be revealed.

### Component Interactions and Procedural Steps:

1. Players A, B, and C place bets and participate in gameplay, with the system tracking their progress toward revealing portions of the mystery jackpot.
2. The mystery jackpot reveal module updates each player's ETGT in real time, showing the revealed portions of the jackpot as players meet gameplay milestones.
3. When the jackpot is triggered, the full prize value is revealed, and the winning player is awarded the jackpot.

### Data Processing:

The system processes player actions and bet data to determine when portions of the mystery jackpot should be revealed. The mystery jackpot reveal module communicates with the jackpot server to update the revealed prize value in real time.

### Outputs and Responses:

Players receive real-time updates on their progress toward revealing the mystery jackpot, with the system displaying the partially revealed jackpot value on their ETGTs. When the jackpot is triggered, the full prize value is revealed to all players, and the winning player is notified of their prize.

### Data Storage and Reporting:

The system stores data on player contributions, revealed portions of the jackpot, and the final prize amount. This data may be used for reporting and analysis, allowing casinos to evaluate the effectiveness of the progressive reveal mechanism and its impact on player engagement.

### Error Handling and Security Measures:

The system includes safeguards to ensure that the progressive reveal of the mystery jackpot is accurately tracked and displayed. Security protocols prevent tampering with the jackpot value or the reveal process, ensuring fairness and transparency for all players.

### End of Interaction:

Once the jackpot is fully revealed and awarded, the system resets the mystery jackpot for the next round of gameplay. Players may continue participating in future games, where a new mystery jackpot will be hidden and progressively revealed based on their actions.

### Mystery Jackpot Eligibility Criteria Example Embodiments

### Eligibility Criteria 1—Time-Based Game Participation

Description and Implementation: Time-Based Game Participation is an eligibility criteria where players who have participated in at least one game during a specific time window, such as a “golden hour”, become eligible for Mystery Jackpot awards at live dealer game tables (LDGTs) and live Dealer-controlled Electronic Table Games systems (DETGs). This criteria may be implemented by configuring the casino's gaming system to track player activity within designated time frames. For example, the casino may designate 8 PM to 9 PM as the “golden hour” each evening. During this period, any player who engages in at least one game at a LDGT or DETG is automatically entered into the pool of eligible participants for the Mystery Jackpot.

The system tracks player activity through player tracking cards or electronic identifiers associated with each Electronic Table Game Terminal (ETGT). When a player initiates a game during the specified time window, the system flags their account as eligible. This eligibility may be visually indicated to players through on-screen notifications at ETGTs or through LED displays at LDGTs. The time-based criteria may be varied to create excitement at different times, such as implementing a “lucky lunch hour” or “midnight madness” period to drive traffic during typically slower periods.

### Benefits to Players:

1. Encourages players to try their luck during specific periods, potentially when jackpots are larger
2. Provides an additional layer of excitement to regular gameplay
3. Offers equal opportunity for both high-rollers and casual players to participate
4. Creates a sense of urgency and excitement around specific time periods

### Benefits to Casinos:

1. Drives traffic and increases game participation during designated time slots
2. Helps manage casino floor traffic by incentivizing play during typically slower periods
3. Creates a buzz and atmosphere of excitement during “golden hours”
4. Encourages players to stay longer or return at specific times
5. Provides flexibility to adjust time windows based on business needs

Example Walk-through Scenario: John, a regular casino patron, arrives at the casino at 7:45 PM. As he approaches the DETG area, he notices the large display announcing that the “Golden Hour” for Mystery Jackpot eligibility will begin at 8:00 PM. Intrigued, John decides to wait and observe the games for a few minutes.

At 7:55 PM, an energetic voice comes over the casino's PA system, announcing that the Golden Hour is about to begin. John, along with several other players, moves towards the DETGs. He inserts his player card into an available ETGT and waits for the clock to strike 8:00 PM.

As soon as the clock hits 8:00 PM, John's ETGT screen lights up with a special animation, indicating that the Golden Hour has begun. A message appears: “Welcome to the Golden Hour! Play any game now to become eligible for the Mystery Jackpot!”

Excited by the prospect, John immediately places a bet on the electronic baccarat game. As soon as his bet is placed, a notification pops up on his screen: “Congratulations! You are now eligible for today's Mystery Jackpot!” The notification also informs him that his eligibility will last for the duration of the Golden Hour, regardless of whether he continues to play or not.

Throughout the hour, John plays several hands of baccarat. He notices that each time a new player joins a table during this period, their screens light up with the eligibility notification. The atmosphere in the casino is electric, with players eagerly watching both their games and the Mystery Jackpot display, which shows the current jackpot amount.

As the Golden Hour nears its end, anticipation builds. At 8:55 PM, another announcement reminds players that they have five minutes left to become eligible. John sees a few last-minute players rushing to place bets before the window closes.

At 9:00 PM, a bell sounds, signaling the end of the Golden Hour. The casino floor buzzes with excitement as players wait to see if the Mystery Jackpot will be awarded. John, along with all the other players who participated during the Golden Hour, knows that he has a chance to win, regardless of the outcome of his individual games.

### Example System Procedural Flow:

1. Casino management configures the “Golden Hour” time frame in the central gaming system.
2. At 7:45 PM, the system triggers notifications across the casino floor about the upcoming Golden Hour.
3. At 8:00 PM, the system activates the Golden Hour eligibility tracking.
4. When a player inserts their card or begins play at an ETGT: a. The ETGT sends a player identification signal to the central system. b. The central system checks if it's within the Golden Hour timeframe. c. If yes, the system flags the player as eligible in the database. d. The system sends a confirmation signal back to the ETGT. e. The ETGT displays the eligibility confirmation to the player.
5. The central system continuously updates the list of eligible players throughout the hour.
6. At 9:00 PM, the system ends the eligibility period and finalizes the list of eligible players.
7. The Mystery Jackpot drawing system selects a winner from the pool of eligible players.
8. If a winner is selected, the system sends a signal to the winning player's ETGT and updates the jackpot displays.
9. The system resets for the next day's Golden Hour event.

### Noteworthy Aspects and Features:

1. Dynamic Time Window: The system allows for flexible configuration of the “Golden Hour,” enabling casinos to adjust the timing based on traffic patterns or special events.
2. Instant Eligibility Confirmation: Players receive immediate feedback on their eligibility status, enhancing the excitement and transparency of the promotion.
3. Persistent Eligibility: Once a player becomes eligible during the Golden Hour, they remain eligible for the entire duration, encouraging initial participation without pressuring continuous play.
4. Multi-Channel Notifications: The system utilizes various communication channels (PA system, ETGT displays, large screens) to create awareness and build excitement.
5. Equal Opportunity Participation: The criteria provides all players, regardless of bet size or duration of play, an equal chance to win the Mystery Jackpot.
6. Automated Eligibility Tracking: The system automatically tracks and manages player eligibility without manual intervention, ensuring accuracy and efficiency.
7. Integration with Player Tracking: By linking eligibility to player cards, the system may provide personalized experiences and gather valuable data on promotion effectiveness.
8. Scalability: This system may be easily scaled to include multiple gaming areas or even multiple casino properties under the same ownership.

### Eligibility Criteria 2—Session Duration

Description and Implementation: Session Duration is an eligibility criteria where players who have continuously played for a minimum specified number of minutes (e.g., 30 minutes) become eligible for Mystery Jackpot awards at live dealer game tables (LDGTs) and live Dealer-controlled Electronic Table Games systems (DETGs). This criteria may be implemented by configuring the casino's gaming system to track the duration of each player's gaming session. The system starts a timer when a player begins their session at a LDGT or DETG, typically initiated by inserting a player card or logging into an Electronic Table Game Terminal (ETGT).

The gaming system continuously monitors the player's activity, ensuring that the session remains active. Short pauses between games or hands are typically allowed without breaking the session, but extended inactivity (e.g., more than 5 minutes without placing a bet) may reset the timer. Once a player reaches the specified duration threshold, they are automatically entered into the pool of eligible participants for the Mystery Jackpot.

Visual indicators on the ETGT screens or LED displays at LDGTs may show players their current session duration and progress towards eligibility. This creates an engaging experience and encourages players to continue their sessions to reach eligibility. The duration threshold may be adjusted based on the casino's preferences, time of day, or specific promotions, allowing for dynamic management of player engagement and floor traffic.

### Benefits to Players:

1. Rewards player loyalty and time investment
2. Provides a clear and achievable goal for jackpot eligibility
3. Enhances the overall gaming experience by adding an extra layer of anticipation
4. Encourages responsible gaming by setting a reasonable time frame for eligibility

### Benefits to Casinos:

1. Increases average player session length and time on device
2. Improves player retention and engagement on the casino floor
3. Provides valuable data on player behavior and session durations
4. Allows for flexible management of floor traffic by adjusting duration requirements
5. Encourages players to try different games to maintain their session, potentially increasing cross-game exposure

Example Walk-through Scenario: Sarah enters the casino on a Tuesday evening and decides to try her luck at the DETGs. She approaches an electronic roulette table and inserts her player card. The screen welcomes her and displays a message: “Play for 30 continuous minutes to become eligible for today's Mystery Jackpot!”

Intrigued, Sarah begins playing. A small timer appears in the corner of her screen, showing her current session duration. As she plays, she notices the timer ticking up. After 15 minutes, a notification pops up: “Halfway there! Keep playing to become eligible for the Mystery Jackpot!”

Sarah continues to play, occasionally switching between roulette and blackjack at the same DETG. The system recognizes these game changes as part of the same continuous session. At 25 minutes, another encouraging message appears: “Just 5 more minutes to go!”

As the 30-minute mark approaches, Sarah feels a surge of excitement. When her timer hits 30 minutes, celebratory graphics flash on her screen, accompanied by a message: “Congratulations! You are now eligible for today's Mystery Jackpot!” The screen also informs her that she will remain eligible as long as she continues to play without long breaks.

Sarah decides to continue playing, now with the added thrill of being eligible for the Mystery Jackpot. She notices other players at nearby ETGTs receiving similar notifications as they reach their 30-minute marks.

After about an hour of play, Sarah decides to take a break for dinner. The system informs her that her eligibility will remain active for 10 minutes after she stops playing. If she returns within this window, her session will continue; otherwise, she'll need to start a new 30-minute session to regain eligibility.

As Sarah enjoys her dinner, she's already planning to return to the DETG area, knowing that she may quickly regain her Mystery Jackpot eligibility with another 30-minute session.

### Example System Procedural Flow:

1. Casino management configures the session duration threshold in the central gaming system.
2. Player inserts card or logs into an ETGT, triggering the system to start a new session timer.
3. The ETGT sends regular activity updates to the central system, including game play and bet information.
4. The central system continuously monitors the session duration for each active player: a. If a player is inactive for a set period (e.g., 5 minutes), the system flags the session for potential reset. b. If activity resumes before the reset threshold, the session continues. c. If the reset threshold is reached, the session timer is reset to zero.
5. When a player reaches the specified duration threshold: a. The central system flags the player as eligible in the database. b. A signal is sent to the player's ETGT to display the eligibility confirmation. c. The player is added to the pool of eligible participants for the Mystery Jackpot.
6. The system continues to monitor the player's activity to maintain eligibility: a. If the player stops playing, a grace period timer starts. b. If play resumes within the grace period, eligibility is maintained. c. If the grace period expires, eligibility is removed until a new qualifying session is completed.
7. The Mystery Jackpot drawing system regularly checks the pool of eligible players for potential winners.
8. If a winner is selected, the system notifies the winning ETGT and updates relevant displays.

### Noteworthy Aspects and Features:

1. Continuous Session Tracking: The system accurately tracks player sessions across different games on the same ETGT, providing a seamless experience for players.
2. Progressive Notifications: Players receive updates on their progress towards eligibility, creating engagement and anticipation.
3. Grace Period Functionality: The inclusion of a grace period allows players to take short breaks without losing their eligibility, enhancing the player experience.
4. Cross-Game Compatibility: The system may track sessions across various game types on a single ETGT, encouraging players to explore different games.
5. Flexible Duration Settings: Casino management may easily adjust the required session duration based on current needs or promotional strategies.
6. Real-time Eligibility Updates: Players are immediately notified when they become eligible, creating instant gratification and excitement.
7. Data-Driven Insights: The tracking of session durations provides valuable data on player behavior and engagement levels.
8. Responsible Gaming Integration: The system may be configured to promote responsible gaming by setting maximum session durations or suggesting breaks after extended play periods.

### Eligibility Criteria 3—Number of Consecutive Wins

Description and Implementation: Number of Consecutive Wins is an eligibility criteria where players who achieve at least X number of consecutive wins within a single session become eligible for Mystery Jackpot awards at live dealer game tables (LDGTs) and live Dealer-controlled Electronic Table Games systems (DETGs). This criteria may be implemented by configuring the casino's gaming system to track and count consecutive wins for each player during their gaming session.

The system monitors each game outcome for every player at LDGTs and DETGs. When a player wins a game, the system starts or continues a consecutive win counter. This counter resets to zero if the player loses a game or doesn't place a bet. Once a player reaches the predetermined number of consecutive wins (e.g., 5 consecutive wins), they are automatically entered into the pool of eligible participants for the Mystery Jackpot.

Electronic Table Game Terminals (ETGTs) may display the current streak and progress towards eligibility, creating an engaging and exciting experience for players. For LDGTs, dealers may be notified of players approaching or reaching eligibility, allowing them to congratulate players and maintain the excitement. The required number of consecutive wins may be adjusted based on the game type, time of day, or specific promotions, allowing the casino to fine-tune the difficulty and frequency of eligibility.

### Benefits to Players:

1. Adds an extra layer of excitement and achievement to regular gameplay
2. Provides a skill-based component to jackpot eligibility
3. Offers a sense of accomplishment separate from monetary winnings
4. Creates memorable experiences through winning streaks

### Benefits to Casinos:

1. Encourages continued play as players try to achieve or maintain winning streaks
2. Generates excitement on the casino floor as players and observers track winning streaks
3. Provides a unique selling point for the casino's electronic and live table games
4. Allows for game-specific promotions based on the difficulty of achieving streaks in different games
5. Potentially increases bet frequency as players aim to maintain their streak

Example Walk-through Scenario: Mike visits the casino on a Friday night and decides to play at the DETGs. He sits down at an electronic blackjack table and inserts his player card. The screen welcomes him and displays a message: “Win 5 hands in a row to become eligible for today's Mystery Jackpot!”

Excited by the challenge, Mike begins playing. After his first win, a small counter appears in the corner of his screen, showing “Streak: 1”. As he wins his second hand, the counter updates to “Streak: 2”, and a message pops up: “Great start! 3 more wins for Mystery Jackpot eligibility!”

Mike's third win in a row causes a bit of a stir, with nearby players glancing over. His ETGT screen now shows an animation of a thermometer filling up, visualizing his progress towards eligibility. The fourth consecutive win ramps up the excitement, with the system announcing “One more win for Mystery Jackpot eligibility!” loud enough for nearby players to hear.

The tension is palpable as Mike plays his fifth hand. He's dealt a 20, and the dealer shows a 6. Mike holds his breath as the dealer reveals a 10, then draws a Queen, busting with 26. Mike's ETGT erupts with lights and sounds, celebrating his fifth consecutive win and newly gained Mystery Jackpot eligibility.

A congratulatory message appears: “Incredible streak! You are now eligible for today's Mystery Jackpot!” The system also informs him that he will remain eligible for the next 10 hands, regardless of their outcome, but may extend his eligibility by continuing his streak.

Encouraged by his success and the added thrill of jackpot eligibility, Mike decides to continue playing. He notices other players at nearby ETGTs seem more engaged, clearly trying to achieve their own winning streaks.

After a few more hands, Mike's streak ends at 7, but he's still riding the high of his achievement and the ongoing Mystery Jackpot eligibility. He decides to try his luck at electronic roulette, knowing that a new streak of 5 consecutive wins there would renew his eligibility.

### Example System Procedural Flow:

1. Casino management configures the consecutive win threshold for Mystery Jackpot eligibility in the central gaming system.
2. Player begins a session at an ETGT or LDGT, triggering the system to initialize a streak counter at zero.
3. For each game played: a. The ETGT or dealer input system sends the game outcome to the central system. b. If the outcome is a win, the central system increments the player's streak counter. c. If the outcome is a loss or no bet, the central system resets the streak counter to zero.
4. The central system continuously monitors each player's streak counter: a. As the counter increases, the system triggers appropriate notifications to the player's ETGT or the dealer's console. b. If the streak counter reaches the predetermined threshold: i. The system flags the player as eligible in the database. ii. A signal is sent to the player's ETGT or dealer's console to confirm eligibility. iii. The player is added to the pool of eligible participants for the Mystery Jackpot.
5. Once eligibility is achieved: a. The system starts a countdown for the number of hands the player remains eligible (e.g., 10 hands). b. This countdown is decremented with each hand played, regardless of outcome. c. If the player achieves another qualifying streak before the countdown ends, the countdown resets.
6. The Mystery Jackpot drawing system regularly checks the pool of eligible players for potential winners.
7. If a winner is selected, the system notifies the winning ETGT or dealer's console and updates relevant displays.

### Noteworthy Aspects and Features:

1. Dynamic Streak Tracking: The system accurately tracks winning streaks across multiple hands, creating an engaging and suspenseful experience.
2. Visual Progress Indicators: ETGTs may display streak counters and progress bars, enhancing player engagement and excitement.
3. Adaptive Difficulty: The required number of consecutive wins may be adjusted based on game type, allowing for balanced implementation across different table games.
4. Extended Eligibility Period: Players maintain eligibility for a set number of hands after achieving a streak, encouraging continued play.
5. Cross-Game Implementation: The system may track streaks across different game types, promoting player exploration of various games.
6. Tiered Eligibility: Casinos may implement tiered eligibility, where longer streaks provide eligibility for larger jackpots or extended eligibility periods.
7. Social Engagement: The visible nature of winning streaks may create a social, competitive atmosphere among players.
8. Skill Recognition: This criteria adds a skill-based element to jackpot eligibility, appealing to players who enjoy strategy and challenge in their gaming experience.

### Eligibility Criteria 4—Multiday Participation

Description and Implementation: Multiday Participation is an eligibility criteria where players who have played on multiple consecutive days at the casino become eligible for Mystery Jackpot awards at live dealer game tables (LDGTs) and live Dealer-controlled Electronic Table Games systems (DETGs). This criteria may be implemented by configuring the casino's player tracking system to monitor and record daily player activity across multiple days.

The system tracks each day a player engages in gameplay at any LDGT or DETG within the casino. When a player reaches a predetermined number of consecutive days with active play (e.g., 3 consecutive days), they are automatically entered into the pool of eligible participants for the Mystery Jackpot. The consecutive day count is maintained as long as the player has any amount of recorded play each day, regardless of the duration or amount wagered.

Electronic Table Game Terminals (ETGTs) may display the player's current consecutive day streak and progress towards Mystery Jackpot eligibility. For LDGTs, this information may be made available to dealers through their console, allowing them to congratulate players on their dedication and inform them of their progress towards eligibility. The required number of consecutive days may be adjusted based on seasonality, special events, or specific promotional periods, providing flexibility in managing player engagement and casino traffic.

### Benefits to Players:

1. Rewards player loyalty and consistent visitation
2. Provides an incentive for regular casino visits
3. Creates a sense of progress and achievement over time
4. Offers an additional way to qualify for jackpots beyond single-session criteria

### Benefits to Casinos:

1. Encourages repeat visits and increases player retention
2. Helps establish daily gaming habits among patrons
3. Provides valuable data on player visitation patterns
4. Allows for targeted marketing based on consecutive day streaks
5. May help increase midweek traffic by incentivizing daily visits

Example Walk-through Scenario: Lisa, a local resident, decides to participate in her casino's new Multiday Participation promotion for Mystery Jackpot eligibility. The promotion may require players to visit and play for three consecutive days to become eligible.

On Monday evening, Lisa visits the casino after work. She inserts her player card into a DETG and is greeted with a message: “Welcome back, Lisa! This is day 1 of your Mystery Jackpot eligibility streak. Visit and play for two more consecutive days to qualify!”

Lisa plays for about an hour, enjoying her favorite electronic table games. As she's about to leave, her ETGT screen displays a reminder: “Great job on day 1! Remember to come back tomorrow to continue your eligibility streak.”

The next day, Tuesday, Lisa returns to the casino. Upon inserting her card, she's congratulated: “Welcome back, Lisa! You're on day 2 of your Mystery Jackpot eligibility streak. Just one more day to go!” Excited about her progress, Lisa plays for a shorter session but ensures she gets some gameplay in to maintain her streak.

On Wednesday, Lisa is tired after work but remembers her streak. She visits the casino and is greeted enthusiastically by her ETGT: “Congratulations, Lisa! This is day 3 of your streak. Play any game today to become eligible for the Mystery Jackpot!” Lisa plays for just 30 minutes, but it's enough to secure her eligibility.

After her third day of play, Lisa receives a celebratory message: “Amazing commitment! You are now eligible for the Mystery Jackpot!” The system informs her that she will remain eligible for the next 24 hours, but may extend her eligibility by continuing her daily visit streak.

Encouraged by her new status, Lisa decides to return the next day, extending her eligibility and streak to 4 days. She notices that the casino seems busier than usual midweek, with other players also trying to maintain their Multiday Participation streaks.

Throughout the week, Lisa feels a sense of accomplishment with each visit. Even on days when she doesn't win, she knows she's building towards Mystery Jackpot eligibility, adding an extra layer of excitement to her regular casino visits.

### Example System Procedural Flow:

1. Casino management configures the consecutive day threshold for Mystery Jackpot eligibility in the central player tracking system.
2. When a player inserts their card or logs into an ETGT:
   a. The system checks the player's activity history.
   b. If the player has activity on the previous day, their consecutive day counter is incremented.
   c. c. If there's no activity on the previous day, the counter resets to 1.
3. The system sends a message to the ETGT or dealer console, informing the player of their current streak and progress towards eligibility.
4. After each gaming session: a. The system logs the player's activity for the day. b. The consecutive day counter is updated in the player's profile.
5. When a player reaches the predetermined consecutive day threshold: a. The system flags the player as eligible in the database. b. A signal is sent to the player's ETGT or dealer's console to confirm eligibility. c. The player is added to the pool of eligible participants for the Mystery Jackpot.
6. Once eligibility is achieved: a. The system starts a timer for the duration of eligibility (e.g., 24 hours). b. If the player visits and plays on the next day, the eligibility period is extended and the consecutive day counter increases.
7. The Mystery Jackpot drawing system regularly checks the pool of eligible players for potential winners.
8. If a winner is selected, the system notifies the winning ETGT or dealer's console and updates relevant displays.
9. The system continues to track daily participation, allowing players to maintain or regain eligibility through consistent visitation.

### Noteworthy Aspects and Features:

1. Long-term Engagement: This criteria encourages player loyalty over an extended period, fostering a habit of regular casino visits.
2. Flexible Gameplay Requirements: Players need only engage in some gameplay each day to maintain their streak, accommodating various schedules and play styles.
3. Progressive Notifications: The system provides daily updates on streak progress, creating anticipation and motivation for return visits.
4. Scalable Difficulty: Casinos may adjust the required number of consecutive days based on seasonality or promotional needs.
5. Cross-Platform Integration: The system may track participation across various game types and platforms (e.g., electronic tables, live tables, slots) to maintain the streak.
6. Tiered Rewards System: Casinos may implement additional rewards or increased jackpot shares for longer streaks, further incentivizing continued participation.
7. Data-Driven Marketing: The consecutive day tracking provides valuable insights for targeted marketing campaigns and personalized promotions.
8. Midweek Traffic Boost: By requiring consecutive days, this system may help increase casino visitation during traditionally slower midweek periods.
9. Community Building: Players on similar streak levels may form social connections, enhancing the overall casino experience.
10. Responsible Gaming Integration: The system may be configured to promote responsible gaming by suggesting breaks or setting maximum streak lengths.

### Eligibility Criteria 5—High Roller Eligibility

Description and Implementation: High Roller Eligibility is a criteria where players with a cumulative wager amount over a specified threshold (e.g., $10,000 in total bets) in a single session become eligible for Mystery Jackpot awards at live dealer game tables (LDGTs) and live Dealer-controlled Electronic Table Games systems (DETGs). This criteria is designed to reward high-stakes players and encourage larger wagers across multiple games or hands.

The system is implemented by configuring the casino's player tracking and wagering systems to monitor and accumulate the total amount wagered by each player during a single gaming session. A session typically starts when a player inserts their card or logs into an Electronic Table Game Terminal (ETGT) and ends when they cash out or remove their card. The system tracks all wagers made during this period, regardless of the game type or outcome.

As players approach the high roller threshold, they may be notified of their progress through on-screen messages at ETGTs or through dealer announcements at LDGTs. Once a player's cumulative wagers reach or exceed the predetermined threshold, they are automatically entered into the pool of eligible participants for the Mystery Jackpot.

The high roller threshold may be dynamically adjusted based on factors such as time of day, day of the week, or special promotional periods. Casinos may also implement tiered thresholds, offering eligibility for different levels of Mystery Jackpots based on the total amount wagered.

### Benefits to Players:

1. Rewards high-stakes play with additional winning opportunities
2. Provides extra value and excitement for players who prefer larger bets
3. Offers a clear and achievable goal for jackpot eligibility based on wagering volume
4. Creates a sense of exclusivity and recognition for high rollers

### Benefits to Casinos:

1. Encourages higher wagering volumes and increased player engagement
2. Attracts and retains high-value players
3. Increases potential revenue through higher bet amounts
4. Allows for targeted marketing and personalized experiences for high rollers
5. Provides valuable data on high-stakes player behavior and preferences

Example Walk-through Scenario: James, a high-stakes player, enters the casino on a Saturday night, ready for an evening of intense gameplay. He approaches a high-limit DETG area and sits down at an electronic baccarat table. Upon inserting his player card, he's greeted with a message: “Welcome, James! Wager a total of $10,000 tonight to become eligible for our exclusive High Roller Mystery Jackpot!”

Intrigued by the challenge, James begins playing. He starts with $500 bets per hand. After a few hands, a discreet counter appears in the corner of his screen, showing his progress towards the high roller threshold: “$2,500/$10,000 wagered.”

As James continues to play, he occasionally increases his bets to $1,000 per hand. His progress towards the threshold accelerates, and he receives encouraging messages: “You're halfway there!” and “Just $2,000 more in wagers to reach High Roller status!”

The excitement builds as James approaches the threshold. Other players in the high-limit area have noticed his substantial bets and are watching with interest. When James places a $1,500 bet that pushes him over the $10,000 threshold, his ETGT screen erupts with a subtle but elegant animation.

A congratulatory message appears: “Congratulations, James! You've achieved High Roller status and are now eligible for today's exclusive Mystery Jackpot!” The message also informs him that he will remain eligible for the next hour, but may extend his eligibility by continuing to place high-stakes wagers.

Energized by his new status, James decides to explore other games while maintaining his high bet amounts. He moves to an electronic roulette table, where his High Roller status is immediately recognized. Other players in the area seem impressed, and some begin to increase their own bets in an attempt to reach the same status.

Throughout the evening, James receives personalized attention from casino staff, who have been alerted to his High Roller status. He's offered complimentary drinks and invited to exclusive high-stakes tournaments, adding to his VIP experience.

As the night progresses, James maintains his eligibility by continuing to place large bets across various games.

He enjoys the added thrill of being in the running for the Mystery Jackpot, knowing that his high-stakes play has earned him this exclusive opportunity.

### Example System Procedural Flow:

1. Casino management configures the high roller wager threshold in the central gaming system.
2. Player begins a session at an ETGT or LDGT by inserting their player card or logging in.
3. The system initializes a wager accumulator for the player's session, starting at zero.
4. For each wager placed: a. The ETGT or dealer input system sends the wager amount to the central system. b. The central system adds the wager amount to the player's accumulator for the session. c. The system compares the updated total to the high roller threshold.
5. As the player approaches the threshold: a. The system triggers progress notifications to the player's ETGT or the dealer's console. b. These notifications become more frequent as the player gets closer to the threshold.
6. When the wager accumulator reaches or exceeds the high roller threshold: a. The system flags the player as eligible for the High Roller Mystery Jackpot in the database. b. A signal is sent to the player's ETGT or dealer's console to confirm eligibility. c. The player is added to the pool of eligible participants for the exclusive Mystery Jackpot.
7. Once eligibility is achieved: a. The system starts a timer for the duration of eligibility (e.g., 1 hour). b. The system continues to track wagers, extending eligibility if high-stakes play continues.
8. The system notifies casino staff of the player's High Roller status for personalized service.
9. The Mystery Jackpot drawing system regularly checks the pool of eligible high rollers for potential winners.
10. If a winner is selected, the system notifies the winning ETGT or dealer's console and updates relevant displays.

### Noteworthy Aspects and Features:

1. Dynamic Threshold Adjustment: The system allows for real-time adjustment of the high roller threshold based on casino occupancy, time of day, or special events.
2. Cross-Game Accumulation: Wagers are accumulated across different game types within the same session, encouraging players to explore various high-stakes offerings.
3. Tiered Eligibility Levels: Casinos may implement multiple thresholds, offering eligibility for different levels of Mystery Jackpots based on wagering volume.
4. Discreet Notifications: Progress updates and eligibility notifications are designed to be noticeable to the player but subtle enough to maintain privacy in high-stakes areas.
5. VIP Experience Integration: The high roller eligibility system may trigger personalized services and offers, enhancing the overall VIP experience.
6. Extended Eligibility Mechanics: Players may maintain or extend their eligibility by continuing high-stakes play, encouraging longer gaming sessions.
7. Data-Driven Insights: The system provides valuable data on high-stakes player behavior, allowing for refined marketing strategies and game offerings.
8. Responsible Gaming Measures: Despite encouraging high-stakes play, the system may incorporate responsible gaming reminders and limits to promote ethical gambling practices.
9. Exclusive Jackpot Pools: High rollers may be entered into exclusive Mystery Jackpot pools with potentially larger payouts, adding to the sense of prestige.
10. Real-Time Staff Alerts: The system may notify casino staff when a player achieves High Roller status, enabling immediate personalized service and attention.

### Eligibility Criteria 6—Group Play Participation

Description and Implementation: Group Play Participation is an innovative eligibility criteria for Mystery Jackpot awards in Live Dealer-controlled Electronic Table Games (DETGs) and Electronic Table Game Terminals (ETGTs). This criteria encourages social interaction and collaborative gameplay by allowing players to join group-mode jackpots or agree to split jackpot winnings with adjacent players.

Implementation involves modifying the DETG software to include a group play option. Players may opt-in to group play mode through the ETGT interface, which then links their gameplay with other participating players at the same table or adjacent terminals. The system tracks all participating players as a single unit for jackpot eligibility purposes.

When activated, the DETG system assigns a unique group identifier to all participating players. This identifier is used to track collective gameplay metrics such as total wagers, time played, and game outcomes. The group's combined activity is then used to determine eligibility for Mystery Jackpot awards.

If a Mystery Jackpot is triggered while in group play mode, the award is either split equally among all participating group members or distributed based on a predetermined allocation method (e.g., proportional to individual wagers).

### Benefits to Players:

1. Enhanced social experience through collaborative gameplay
2. Increased chances of winning jackpots by pooling resources
3. Reduced individual risk while maintaining potential for large rewards
4. Opportunity to celebrate wins collectively, fostering a sense of camaraderie

### Benefits to Casinos:

1. Increased player engagement and longer play sessions
2. Promotion of a social atmosphere, attracting more players to DETGs
3. Potential for higher overall wager volumes due to group participation
4. Unique selling point to differentiate from competitors and attract social players

Example Walk-through Scenario: John, Sarah, and Mike are friends visiting a casino with DETGs featuring the Group Play Participation option for Mystery Jackpot eligibility. They approach a baccarat table with three available ETGTs and decide to try their luck together.

Upon sitting down, each player logs into their ETGT using their player cards. The screens display an option to “Join Group Play” for Mystery Jackpot eligibility. All three friends select this option, and their screens prompt them to confirm participation and agree to split any potential Mystery Jackpot winnings equally.

Once confirmed, the ETGTs display a notification that they are now part of “Group A” for Mystery Jackpot purposes. A small icon appears on each screen, indicating active group participation.

As they play, the friends notice that their individual wagers contribute to a collective group total displayed on their screens. This total represents their combined eligibility progress towards Mystery Jackpot qualification.

During gameplay, the dealer announces that a Mystery Jackpot will be awarded in the next 15 minutes to a randomly selected eligible group or individual player. This creates excitement among all players at the table.

Ten minutes later, lights flash on the friends' ETGTs, and a celebratory animation appears on their screens. The system announces that “Group A” has won the Mystery Jackpot of $3,000. Each player's screen displays their individual share of $1,000.

The casino staff verifies the win and processes the payout. John, Sarah, and Mike celebrate their collective win, appreciating how the Group Play option allowed them to share in the excitement and reward of the Mystery Jackpot.

After their win, the friends decide to continue playing as a group, enjoying the social aspect and the potential for more shared wins. Their positive experience encourages other nearby players to consider opting into Group Play for future games.

### Example System Procedural Flow:

1. Player initiates Group Play option on ETGT interface
2. ETGT sends group play request to central DETG server
3. Server verifies player eligibility for group play
4. Server assigns unique group identifier to participating players
5. ETGTs of all group members updated with group status and identifier
6. Server begins tracking collective group metrics (wagers, time played, etc.)
7. Individual player actions are processed normally but also contribute to group totals
8. Server continuously evaluates group's eligibility for Mystery Jackpot based on predefined criteria
9. If Mystery Jackpot is triggered, server checks if winning player/group is in Group Play mode
10. For group winners, server calculates individual shares based on predetermined split method
11. Server sends win notification and individual payout amounts to relevant ETGTs
12. ETGTs display win information and payout amounts to players
13. Server updates jackpot pool and resets for next award
14. Transaction logs updated with group play jackpot win details
15. Players may choose to continue group play or opt out for subsequent games

Noteworthy Aspects and Features: The Group Play Participation criteria for Mystery Jackpot eligibility introduces several novel aspects to DETG gameplay:
1. Dynamic Group Formation: Players may form ad-hoc groups on the fly, promoting spontaneous social interactions.
2. Flexible Participation: The system allows players to join or leave group play between games, providing flexibility.
3. Cross-Game Compatibility: Group Play may be implemented across various DETG games, enhancing its appeal.
4. Scalable Group Sizes: The system may accommodate different group sizes, from pairs to larger ensembles.
5. Transparent Contribution Tracking: Players may view their individual contributions to the group's overall eligibility.
6. Customizable Payout Structures: Casinos may implement various payout allocation methods for group wins.
7. Social Responsibility Features: The system may include options for players to set group play limits or time restrictions.
8. Inter-Group Competitions: Casinos may implement tournaments or challenges between different groups, further enhancing the social aspect.
9. Real-Time Group Performance Metrics: The system provides live updates on the group's performance and eligibility status.
10. Integration with Player Loyalty Programs: Group Play activity may be tied to individual and collective rewards in the casino's loyalty scheme.

### Eligibility Criteria 7—VIP Status

Description and Implementation: VIP Status as an eligibility criteria for Mystery Jackpot awards in Live Dealer-controlled Electronic Table Games (DETGs) and Electronic Table Game Terminals (ETGTs) is based on a player's loyalty tier within the casino's player tracking system. This criteria rewards high-value players and encourages loyalty by providing exclusive access to Mystery Jackpot opportunities.

Implementation involves integrating the DETG system with the casino's existing player tracking database. When a player inserts their loyalty card or logs into an ETGT, the system queries their current status (e.g., Gold, Platinum, or Diamond). Based on predetermined rules, certain VIP tiers automatically qualify for Mystery Jackpot eligibility.

The DETG software may be configured to offer tiered Mystery Jackpot pools, with higher-value jackpots available to higher-tier players. For example, Gold members may be eligible for a base Mystery Jackpot, while Platinum and Diamond members have access to progressively larger jackpots.

Additionally, the system may be set up to provide VIP players with a higher probability of triggering Mystery Jackpots or offer them exclusive time windows when only VIP players are eligible for certain jackpots.

### Benefits to Players:

1. Exclusive access to larger Mystery Jackpot pools
2. Increased value and rewards for loyalty to the casino
3. Additional excitement and incentive for high-tier players
4. Clear pathway for progression and increased benefits

### Benefits to Casinos:

1. Encourages player loyalty and progression through VIP tiers
2. Attracts and retains high-value players
3. Provides additional marketing opportunities for VIP programs
4. Increases overall player engagement and time on device

Example Walk-through Scenario: Linda, a Platinum-tier member of the casino's loyalty program, decides to play baccarat at a DETG. She approaches an available ETGT and inserts her player card. The system recognizes her Platinum status, and a welcome message appears: “Welcome back, Linda! As a valued Platinum member, you have exclusive access to our Platinum Mystery Jackpot pool.”

As Linda begins to play, she notices a special Platinum Mystery Jackpot meter on her screen, showing a larger jackpot amount than the standard Mystery Jackpot displayed on non-VIP terminals. The screen also indicates that Platinum members have a 1.5× higher chance of triggering the Mystery Jackpot compared to standard players.

During her session, Linda receives a notification: “Platinum Exclusive: Mystery Jackpot opportunity activated for the next 30 minutes!” This indicates a time window where only Platinum and higher-tier players are eligible for the Mystery Jackpot.

As Linda continues to play, she sees another Platinum player at a nearby ETGT win a significant Mystery Jackpot. This reinforces the value of her VIP status and encourages her to continue playing.

After an hour of play, Linda's screen suddenly lights up with a celebratory animation. “Congratulations! You've won the Platinum Mystery Jackpot of $25,000!” The win is verified by casino staff, and Linda is escorted to the VIP services desk for processing of her large payout.

While at the VIP desk, a casino host informs Linda that if she reaches Diamond status, she'll be eligible for even larger Mystery Jackpots and more frequent VIP-exclusive jackpot windows. This motivates Linda to consider increasing her play to reach the next tier.

As news of Linda's win spreads, other players in the casino take note. Some regular players inquire about how to reach Platinum status, while other VIP players are encouraged to try the DETGs, knowing they have access to exclusive Mystery Jackpot opportunities.

### Example System Procedural Flow:

1. Player inserts loyalty card or logs into ETGT
2. ETGT sends player ID to central DETG server
3. Server queries casino's player tracking database for VIP status
4. Player's VIP tier is returned to the server and ETGT
5. ETGT updates interface to display appropriate VIP-level Mystery Jackpot information
6. Server adjusts Mystery Jackpot eligibility and probability based on VIP tier
7. Player's gameplay is monitored by server, factoring in VIP status for jackpot triggers
8. If VIP-exclusive jackpot window is activated, server notifies eligible ETGTs
9. Non-eligible ETGTs are temporarily excluded from jackpot participation
10. If Mystery Jackpot is triggered, server verifies winner's VIP status
11. Jackpot amount is determined based on winner's VIP tier
12. Server sends win notification and payout amount to winner's ETGT
13. ETGT displays win information and initiates celebration sequence
14. Server updates jackpot pool and resets for next award
15. Win data is recorded in player's loyalty account and VIP host is notified for follow-up

Noteworthy Aspects and Features: The VIP Status eligibility criteria for Mystery Jackpot awards introduces several innovative features to DETG gameplay:
1. Tiered Jackpot Pools: Different jackpot amounts available based on player's loyalty status.
2. Dynamic Eligibility Adjustment: System may automatically adjust eligibility and win probabilities based on real-time VIP status.
3. Exclusive Time Windows: Ability to create VIP-only periods for Mystery Jackpot eligibility.
4. Integrated Loyalty Progression: Mystery Jackpot wins may contribute to player's progress towards higher VIP tiers.
5. Personalized Jackpot Displays: ETGTs show jackpot information tailored to the player's VIP level.
6. VIP Host Notifications: Automatic alerts to casino staff for high-value wins, enabling personalized service.
7. Flexible Tier Configuration: Casino may easily adjust which VIP tiers are eligible for various jackpot levels.
8. Cross-Promotion Opportunities: System may promote other VIP benefits during Mystery Jackpot gameplay.
9. Data-Driven VIP Insights: Jackpot participation data may inform casino's VIP marketing strategies.
10. Scalable Reward Structure: Easily adaptable to accommodate new VIP tiers or special promotional statuses.

### Eligibility Criteria 8—Total Number of Games Played

Description and Implementation: The Total Number of Games Played eligibility criteria for Mystery Jackpot awards in Live Dealer-controlled Electronic Table Games (DETGs) and Electronic Table Game Terminals (ETGTs) is based on the cumulative number of games a player participates in across multiple terminals. This criteria rewards player engagement and consistency, encouraging longer play sessions and exploration of different games.

Implementation involves the DETG system tracking each player's game participation across all connected ETGTs. When a player logs into any ETGT using their player card or account, the system retrieves their current game count and continues to increment it with each game played. Once a predetermined threshold is reached (e.g., 50 games), the player becomes eligible for Mystery Jackpot participation.

The system may be configured to offer tiered eligibility, where players unlock access to larger or more frequent Mystery Jackpot opportunities as they reach higher game count milestones. Additionally, the criteria may be set to reset daily, weekly, or monthly to encourage regular visits and sustained engagement.

To add further depth, the system may weight games differently based on factors such as game type, bet size, or time of day, allowing for strategic player engagement initiatives.

### Benefits to Players:

1. Rewards consistent play and engagement
2. Provides a clear, achievable goal for jackpot eligibility
3. Encourages exploration of different games and ETGTs
4. Adds an extra layer of excitement to extended play sessions

### Benefits to Casinos:

1. Increases player retention and time on device
2. Encourages players to try multiple game types
3. Provides valuable data on player preferences and behaviors
4. Facilitates targeted marketing based on play frequency

Example Walk-through Scenario: Tom visits a casino featuring DETGs with the Total Number of Games Played Mystery Jackpot eligibility criteria. He decides to start his session at a blackjack ETGT. Upon logging in with his player card, a pop-up message appears: “Welcome back, Tom! You've played 37 games so far. Play 13 more to unlock Mystery Jackpot eligibility!”

Excited by the prospect, Tom begins playing blackjack. After each hand, a small counter in the corner of his screen updates, showing his progress towards the 50-game threshold. As he approaches the target, anticipation builds.

After his 50th game, a celebratory animation plays on his screen: “Congratulations! You've unlocked Mystery Jackpot eligibility. Every game you play now has a chance to trigger a Mystery Jackpot!” Energized by this new opportunity, Tom decides to continue playing. He notices that his game counter keeps increasing beyond 50. A tooltip explains that reaching higher game counts unlocks access to larger Mystery Jackpots.

After a while, Tom decides to try his luck at a baccarat ETGT. Upon logging in, he's pleased to see that his game count has carried over from the blackjack table. The new ETGT informs him that he's now eligible for both baccarat and multi-game Mystery Jackpots.

As Tom reaches his 75th game, his screen suddenly erupts in a dazzling display of lights and sounds. “Mystery Jackpot Triggered! You've won $5,000!” The win is verified by casino staff, and Tom is overjoyed with his unexpected windfall.

Motivated by his success, Tom decides to aim for the next milestone of 100 games, which promises access to even larger Mystery Jackpots. He plans to visit the casino again soon to continue his progress, now seeing each game as a step towards potentially bigger rewards.

Throughout his session, Tom notices other players checking their game counts and discussing strategies for reaching eligibility thresholds, adding a new layer of engagement to the DETG experience.

### Example System Procedural Flow:

1. Player logs into ETGT using player card or account
2. ETGT sends player ID to central DETG server
3. Server retrieves player's current game count from database
4. ETGT displays current game count and eligibility status to player
5. As player participates in games, ETGT sends game completion signals to server
6. Server increment scale player's game count in real-time
7. Server checks if new game count reaches eligibility threshold
8. If threshold reached, server updates player's eligibility status
9. ETGT notifies player of newly unlocked eligibility or milestone reached
10. Server adjusts Mystery Jackpot trigger probability based on player's game count
11. With each game played, server calculates if Mystery Jackpot is triggered
12. If jackpot triggered, server determines award amount based on game count tier
13. Server sends win notification and amount to player's ETGT
14. ETGT displays win information and initiates celebration sequence
15. Server updates jackpot pool, resets for next award, and logs win data
16. Player's game count continues to accumulate until reset period (e.g., daily at midnight)

Noteworthy Aspects and Features: The Total Number of Games Played eligibility criteria introduces several innovative aspects to DETG gameplay:
1. Cross-ETGT Tracking: Allows players to accumulate games across different terminals and game types.
2. Tiered Eligibility System: Unlocks access to larger or more frequent jackpots as players reach higher game count milestones.
3. Flexible Reset Periods: Configurable reset intervals (daily, weekly, monthly) to suit different casino strategies.
4. Game Weighting: Ability to assign different values to games based on type, bet size, or other factors.
5. Real-Time Progress Tracking: Instant updates on game count and eligibility status.
6. Multi-Level Engagement: Combines short-term goals (reaching eligibility) with long-term incentives (higher tiers).
7. Cross-Promotion Tool: Encourages players to try different game types to increase their count.
8. Data-Rich Player Insights: Provides detailed information on player preferences and behaviors.
9. Customizable Thresholds: Easily adjustable eligibility and tier thresholds to optimize player engagement.
10. Integration with Loyalty Programs: Game counts may contribute to broader loyalty point accumulation or status upgrades.

### Eligibility Criteria 9—Cross-Game Play

Description and Implementation: Cross-Game Play as an eligibility criteria for Mystery Jackpot awards in Live Dealer-controlled Electronic Table Games (DETGs) and Electronic Table Game Terminals (ETGTs) encourages players to experience a variety of games during their casino visit. This criteria rewards players who engage with multiple game types, such as blackjack, baccarat, and poker, within a single casino session.

Implementation involves the DETG system tracking each player's game variety across all connected ETGTs. When a player logs into any ETGT, the system records the game type played. As the player moves between different games, the system updates their cross-game play status. Once a player has participated in a predetermined number of different games (e.g., at least three), they become eligible for Mystery Jackpot participation.

The system may be configured to offer escalating jackpot tiers based on the number of different games played. For instance, playing three different games may unlock basic eligibility, while playing five or more may provide access to premium Mystery Jackpot pools.

Additionally, the criteria may include time-based elements, requiring players to experience multiple games within a specific timeframe to maintain eligibility, encouraging active exploration of the casino's DETG offerings.

### Benefits to Players:

1. Encourages exploration of various casino games
2. Provides a more diverse and engaging gaming experience
3. Offers additional excitement and reward potential for trying new games
4. Helps players discover new favorites they may have otherwise overlooked

### Benefits to Casinos:

1. Promotes engagement with a wider range of casino offerings
2. Increases player time on device across multiple game types
3. Generates valuable data on player preferences and game popularity
4. Facilitates introduction of new games to players

Example Walk-through Scenario: Emily visits a casino featuring DETGs with the Cross-Game Play Mystery Jackpot eligibility criteria. She begins her session at a blackjack ETGT. Upon logging in, a message appears: “Welcome, Emily! Experience the variety of our games to unlock Mystery Jackpot eligibility. Current status: ⅓ games played.”

After playing blackjack for a while, Emily decides to try her luck at roulette. As she logs into a roulette ETGT, the screen updates: “Great choice! You've now played ⅔ games needed for Mystery Jackpot eligibility.”

Intrigued by the prospect of unlocking jackpot eligibility, Emily asks a casino host about other available games. The host recommends baccarat and mentions that playing a third game will unlock Mystery Jackpot eligibility.

Emily moves to a baccarat ETGT. Upon logging in, an exciting animation plays: “Congratulations! You've unlocked Mystery Jackpot eligibility by playing 3 different games. Every game you play now has a chance to trigger a Mystery Jackpot!”

As Emily plays baccarat, she notices a new meter on her screen showing her cross-game play status. It indicates that if she plays two more unique games, she'll unlock Premium Mystery Jackpot eligibility with larger potential prizes.

Excited by this, Emily decides to try poker and then sic bo, completing five unique games. Her ETGT screen updates: “You've achieved Premium Mystery Jackpot status! You now have access to our largest Mystery Jackpot pools across all games.”

During her sic bo game, the screen suddenly erupts in a celebration of lights and sounds. “Premium Mystery Jackpot Triggered! You've won $10,000!” The win is verified, and Emily is ecstatic about her decision to explore different games.

As news of Emily's win spreads, other players become more interested in trying various games. The casino floor sees increased movement between different DETG types as players seek to unlock their own Mystery Jackpot eligibility.

Emily ends her session with a newfound appreciation for the variety of games offered and plans future visits to maintain her Premium eligibility status by continuing to engage with multiple game types.

### Example System Procedural Flow:

1. Player logs into ETGT using player card or account
2. ETGT sends player ID and game type to central DETG server
3. Server retrieves player's current cross-game play status from database
4. ETGT displays current status and games played to player
5. As player completes games, ETGT sends game completion signals to server
6. Server updates player's cross-game play status in real-time
7. Server checks if new status reaches eligibility threshold
8. If threshold reached, server updates player's eligibility status
9. ETGT notifies player of newly unlocked eligibility or tier reached
10. Server adjusts Mystery Jackpot trigger probability based on player's status
11. With each game played, server calculates if Mystery Jackpot is triggered
12. If jackpot triggered, server determines award amount based on eligibility tier
13. Server sends win notification and amount to player's ETGT
14. ETGT displays win information and initiates celebration sequence
15. Server updates jackpot pool, resets for next award, and logs win data
16. Player's cross-game play status persists for the duration of their casino visit or until a predetermined reset time

Noteworthy Aspects and Features: The Cross-Game Play eligibility criteria introduces several innovative aspects to DETG gameplay:
1. Multi-Game Engagement: Encourages players to experience a variety of games, enhancing overall casino experience.
2. Tiered Eligibility System: Offers escalating rewards for players who engage with more game types.
3. Dynamic Eligibility Tracking: Real-time updates on cross-game play status across all ETGTs.
4. Flexible Game Weighting: Ability to assign different values to games based on popularity or house edge.
5. Time-Based Elements: Option to may require multiple games within a specific timeframe for eligibility.
6. Personalized Game Recommendations: System may suggest new games to try based on player's history.
7. Cross-Promotion Tool: Naturally introduces players to a wider range of casino offerings.
8. Data-Rich Player Insights: Provides detailed information on game preferences and player exploration patterns.
9. Customizable Thresholds: Easily adjustable game count and tier thresholds to optimize engagement.
10. Integration with Casino Events: May be tied to game tournaments or new game launches to drive participation.

### Eligibility Criteria 10—Referral Bonus

Description and Implementation: The Referral Bonus eligibility criteria for Mystery Jackpot awards in Live Dealer-controlled Electronic Table Games (DETGs) and Electronic Table Game Terminals (ETGTs) incentivizes existing players to introduce new players to the casino's DETG offerings. This criteria rewards players who successfully refer new patrons, tracked via a referral code, with eligibility for Mystery Jackpot participation.

Implementation involves integrating a referral system into the casino's player tracking and DETG software. Existing players are provided with unique referral codes that they may share with friends or family. When a new player signs up and enters this code, it's recorded in the system. Once the new player meets certain criteria (e.g., playing a minimum number of games or wagering a specific amount), the referring player gains Mystery Jackpot eligibility.

The system may be configured to offer tiered rewards based on the number of successful referrals or the activity level of referred players. For instance, referring one new player may grant basic eligibility, while multiple successful referrals may unlock access to premium Mystery Jackpot pools.

Additionally, the criteria may include time-based elements, where the referral bonus eligibility lasts for a specific duration, encouraging ongoing referral activity.

### Benefits to Players:

1. Rewards players for bringing new patrons to the casino
2. Provides additional opportunities to win jackpots without additional personal wagers
3. Enhances social aspect of gaming by encouraging friends to play together
4. Offers a way for frequent players to gain extra benefits

### Benefits to Casinos:

1. Leverages existing player base for new customer acquisition
2. Increases overall player engagement and visitation
3. Potentially lowers marketing costs through player-driven referrals
4. Provides data on player networks and social connections

Example Walk-through Scenario: Mark is a regular at a casino featuring DETGs with the Referral Bonus Mystery Jackpot eligibility criteria. During one of his visits, he receives a notification on his ETGT: “Refer a friend and unlock Mystery Jackpot eligibility! Your unique referral code is MARK123.”

Excited by this opportunity, Mark decides to invite his friend Sarah, who has never played at this casino before. He sends her the referral code via text message.

A week later, Sarah visits the casino and signs up for a player card, entering Mark's referral code MARK123. As she begins to play at an ETGT, the system recognizes the referral code and links her account to Mark's.

As Sarah plays, Mark receives a notification on his ETGT during his next visit: “Good news! Your referred friend has started playing. Once they wager $100, you'll unlock Mystery Jackpot eligibility !”

Over the next few days, Sarah continues to play at the DETGs. When she crosses the $100 wager threshold, Mark receives another notification: “Congratulations! Your referral has qualified. You now have Mystery Jackpot eligibility for the next 30 days!”

Excited by this new opportunity, Mark increases his playing frequency over the next month. During one of his sessions, his screen suddenly erupts in a celebration of lights and sounds. “Mystery Jackpot Triggered! You've won $7,500 thanks to your referral bonus eligibility!”

As Mark celebrates his win, he notices an additional message: “Refer more friends to extend and upgrade your Mystery Jackpot eligibility!” This motivates Mark to reach out to more of his friends, explaining how his referral led to a significant win.

Sarah, upon hearing about Mark's win, becomes more engaged with the DETGs herself. She also receives a notification about the referral program, creating a chain effect of new players joining and existing players gaining extended Mystery Jackpot eligibility.

The casino floor sees an increase in groups of friends playing together at DETGs, all hoping to benefit from the referral bonus and potentially trigger Mystery Jackpots.

### Example System Procedural Flow:

1. Existing player receives unique referral code from ETGT or casino staff
2. New player signs up at casino and enters referral code
3. System links new player's account to referring player's account
4. System tracks new player's activity (wagers, games played, etc.)
5. Once new player meets qualification criteria, system updates referring player's status
6. Referring player is notified of unlocked Mystery Jackpot eligibility
7. System activates Mystery Jackpot eligibility for referring player
8. During eligible period, system includes referring player in Mystery Jackpot calculations
9. If Mystery Jackpot is triggered, system verifies player's eligibility
10. System determines jackpot amount based on referral tier or other factors
11. ETGT displays win information and initiates celebration sequence
12. System updates jackpot pool and resets for next award
13. Win data is logged, including referral information
14. System checks for additional referrals to extend or upgrade eligibility
15. Referral data is analyzed for marketing insights and program optimization
16. System sends periodic reminders to players about their referral status and opportunities

Noteworthy Aspects and Features: The Referral Bonus eligibility criteria introduces several innovative aspects to DETG gameplay:
1. Player-Driven Acquisition: Turns existing players into brand ambassadors for the casino.
2. Multi-Tiered Reward Structure: Offers escalating benefits for multiple successful referrals.
3. Time-Based Eligibility: Encourages ongoing referral activity to maintain jackpot eligibility.
4. Dual Incentive System: Rewards both the referrer and the new player.
5. Social Gaming Enhancement: Promotes group play and social interactions at DETGs.
6. Dynamic Eligibility Tracking: Real-time updates on referral status and resulting jackpot eligibility.
7. Flexible Qualification Criteria: Allows casinos to set and adjust thresholds for successful referrals.
8. Cross-Promotion Opportunities: May be integrated with other casino offerings or events.
9. Data-Rich Network Insights: Provides valuable information on player relationships and influence.
10. Customizable Reward Mechanics: Ability to offer various incentives beyond jackpot eligibility (e.g., free play, comps) for successful referrals.

### Eligibility Criteria 11—Bet Variety

Description and Implementation: Bet Variety as an eligibility criteria for Mystery Jackpot awards in Live Dealer-controlled Electronic Table Games (DETGs) and Electronic Table Game Terminals (ETGTs) encourages players to engage in diverse betting patterns within a single game session. This criteria rewards players who demonstrate a range of betting behaviors, specifically by placing both minimum and maximum bets during their gameplay.

Implementation involves the DETG system tracking each player's betting patterns in real-time. The system monitors the bet amounts placed by the player, keeping record of the minimum and maximum bets made during a session. When a player has placed both a minimum bet (as defined by the table limits) and a maximum bet within a specified timeframe or number of hands, they become eligible for Mystery Jackpot participation.

The system may be configured to offer tiered eligibility based on the frequency or extent of bet variety. For instance, occasionally alternating between min and max bets may grant basic eligibility, while consistently varying bet sizes across a wider range may unlock access to premium Mystery Jackpot pools.

Additionally, the criteria may include game-specific elements, where bet variety requirements are tailored to the unique betting structures of different games (e.g., blackjack vs. baccarat).

### Benefits to Players:

1. Encourages strategic and dynamic betting behavior
2. Provides additional excitement by incentivizing varied gameplay
3. Offers a new dimension of skill and strategy in managing bets
4. Potentially increases winning opportunities through diverse betting

### Benefits to Casinos:

1. Promotes higher average bets by incentivizing occasional maximum wagers
2. Increases player engagement and time on device
3. Generates valuable data on betting patterns and risk appetites
4. Potentially increases overall handle and theoretical win

Example Walk-through Scenario: Lisa visits a casino featuring DETGs with the Bet Variety Mystery Jackpot eligibility criteria. She sits down at a blackjack ETGT with table limits of $10 minimum and $500 maximum. Upon logging in, a message appears: “Mix up your bets to unlock Mystery Jackpot eligibility! Place both a minimum and maximum bet to qualify.”

Lisa begins playing with her usual $25 bets. After a few hands, she decides to try for the Mystery Jackpot eligibility. She places a $10 minimum bet, and the system acknowledges this with a subtle notification: “Minimum bet placed. Place a maximum bet to complete Bet Variety challenge!”

Excited by the prospect, Lisa waits for what she feels is a favorable situation and places a $500 maximum bet. As soon as she confirms this bet, her screen displays an congratulatory animation: “Congratulations! You've unlocked Mystery Jackpot eligibility through Bet Variety. Every hand now has a chance to trigger a Mystery Jackpot!”

As Lisa continues to play, she notices a new meter on her screen showing her Bet Variety status. It indicates that maintaining a mix of bet sizes will keep her eligibility active and may even upgrade her to Premium Mystery Jackpot status.

Intrigued, Lisa begins to strategically vary her bets more often, mixing in occasional minimum and maximum bets with her standard wagers. This new approach adds an extra layer of excitement to her gameplay.

During one of her hands with a $250 bet, the screen suddenly erupts in a celebration of lights and sounds. “Mystery Jackpot Triggered! You've won $15,000!” The win is verified, and Lisa is ecstatic about her decision to vary her betting pattern.

As news of Lisa's win spreads, other players at nearby ETGTs become more interested in the Bet Variety criteria. The casino floor sees an increase in dynamic betting patterns as players seek to unlock and maintain their own Mystery Jackpot eligibility.

Lisa ends her session with a newfound appreciation for strategic bet placement and plans future visits to explore this new dimension of gameplay, excited by the potential for more Mystery Jackpot opportunities.

### Example System Procedural Flow:

1. Player logs into ETGT using player card or account
2. ETGT sends player ID and game type to central DETG server
3. Server retrieves player's current Bet Variety status from database
4. ETGT displays current status and Bet Variety challenge to player
5. As player places bets, ETGT sends bet amount data to server
6. Server tracks minimum and maximum bets placed in real-time
7. Server checks if Bet Variety criteria (min and max bets) are met
8. If criteria met, server updates player's eligibility status
9. ETGT notifies player of newly unlocked eligibility or tier reached
10. Server adjusts Mystery Jackpot trigger probability based on player's status
11. With each hand played, server calculates if Mystery Jackpot is triggered
12. If jackpot triggered, server determines award amount based on eligibility tier
13. Server sends win notification and amount to player's ETGT
14. ETGT displays win information and initiates celebration sequence
15. Server updates jackpot pool, resets for next award, and logs win data
16. Player's Bet Variety status is continuously monitored for maintaining eligibility

Noteworthy Aspects and Features: The Bet Variety eligibility criteria introduces several innovative aspects to DETG gameplay:
1. Dynamic Betting Incentive: Encourages players to explore different betting strategies within their comfort zone.
2. Tiered Eligibility System: Offers escalating rewards for more consistent or extreme bet variety.
3. Real-time Bet Tracking: Continuous monitoring and analysis of betting patterns.
4. Game-Specific Adaptability: Criteria may be tailored to suit different game types and betting structures.
5. Risk Management Tool: Indirectly promotes responsible gambling by encouraging occasional lower bets.
6. Skill Element Introduction: Adds a layer of strategy to jackpot eligibility beyond mere chance.
7. Personalized Betting Challenges: System may offer customized Bet Variety goals based on player history.
8. Cross-Game Applicability: Concept may be applied across various DETG types for consistent experience.
9. Data-Rich Player Insights: Provides detailed information on risk tolerance and betting behaviors.
10. Integration with Table Limits: Leverages existing min/max bet structures to define eligibility criteria.

### Eligibility Criteria 12—Side Bet Contribution

Description and Implementation: This eligibility criterion is based on players who have contributed to a side bet specifically allocated to fund the Mystery Jackpot. In this implementation, the Electronic Table Game Terminal (ETGT) offers players the option to place an additional side bet during regular gameplay. This side bet is separate from the main game wager and is explicitly designated for the Mystery Jackpot pool. The ETGT may display a dedicated area on the touch screen for placing this side bet, clearly labeled as “Mystery Jackpot Contribution” or similar.

The system tracks each player's side bet contributions over time, potentially across multiple gaming sessions. Players who consistently contribute to this side bet become eligible for Mystery Jackpot awards. The contribution threshold may be set as a cumulative amount (e.g., $50 total side bets) or based on frequency (e.g., placing the side bet in 10 consecutive games). This implementation allows for flexible jackpot funding and creates a direct link between player contributions and jackpot eligibility.

Benefits to Players: Players benefit from this system by having direct control over their eligibility for the Mystery Jackpot. They may choose when and how much to contribute, allowing for strategic gameplay decisions. This system also provides a sense of fairness, as players know their contributions are directly funding the jackpot they have a chance to win. Additionally, it adds an extra layer of excitement to each game, as players anticipate not just the main game outcome but also the potential for a Mystery Jackpot win.

Benefits to Casinos: For casinos, this eligibility criterion offers several advantages. It provides a consistent and predictable funding mechanism for the Mystery Jackpot, ensuring its sustainability. The side bet system may also increase overall gaming revenue by encouraging additional wagers. It allows casinos to offer larger jackpots without significantly impacting the house edge of the main game. Furthermore, this system may drive player engagement and loyalty, as players may be motivated to continue playing to maintain their eligibility status.

Example Walk-through Scenario: John sits down at a baccarat ETGT and inserts his player card. The screen displays the main betting area for baccarat, along with a separate section for the “Mystery Jackpot Side Bet.” A notification pops up explaining that players who contribute $50 in side bets become eligible for the Mystery Jackpot, currently at $100,000.

John decides to participate and places a $5 side bet along with his main baccarat wager. After each hand, the system prompts John if he'd like to place another side bet. John continues to play, consistently placing the $5 side bet. After 10 hands, a message appears: “Congratulations! You've contributed $50 to the Mystery Jackpot and are now eligible for the next 24 hours!”

Throughout his session, John notices the jackpot amount increasing, partly due to his contributions and those of other players. Even when John doesn't win at baccarat, he remains engaged, knowing each hand brings the possibility of winning the Mystery Jackpot.

After a few hours of play, during a regular baccarat hand, suddenly the ETGT's lights flash, and a celebratory sound plays. A message appears: “Congratulations, John! You've won a Mystery Jackpot of $2,500!” John realizes his consistent side bet contributions not only made him eligible but also helped fund the very jackpot he just won.

Example System Procedural Flow:
1. Player inserts card or buys in at the ETGT
2. ETGT system recognizes player and retrieves player data
3. ETGT displays main game and Mystery Jackpot side bet options
4. Player places main wager and optional Mystery Jackpot side bet
5. ETGT sends bet information to central server
6. Central server records side bet amount and updates player's contribution total
7. If player's total contribution reaches threshold, server flags player as eligible
8. ETGT receives eligibility confirmation and notifies player
9. During each game round, server checks for Mystery Jackpot trigger conditions
10. If triggered, server selects winner from eligible players
11. Winning ETGT receives jackpot win signal and initiates payout process
12. Central server updates jackpot amount and resets for next round
13. All ETGTs update displayed jackpot amount

Noteworthy Aspects and Features: This eligibility criterion introduces several novel aspects to Mystery Jackpot implementations. The direct link between player contributions and jackpot eligibility creates a transparent and fair system, which is often lacking in traditional mystery jackpots. The ability to track contributions across multiple sessions encourages player loyalty and repeat visits.

The flexibility in setting contribution thresholds allows casinos to fine-tune the system based on player behavior and desired jackpot frequencies. The side bet system also provides valuable data on player preferences and risk appetites, which casinos may use for personalized marketing and game development.

Moreover, this system may be expanded to offer tiered eligibility, where higher contributions unlock access to larger jackpots or increase the chances of winning. This scalability adds depth to the player experience and provides additional incentives for increased play.

### Eligibility Criteria 13—Game Mode Participation

Description and Implementation: This eligibility criterion is based on players who activate special game modes, such as a speed round or bonus game mode, to become eligible for Mystery Jackpot awards. In this implementation, the Electronic Table Game Terminal (ETGT) offers players the option to enter special game modes during their gaming session. These modes may include fast-paced “Speed Rounds,” high-stakes “VIP Modes,” or themed “Bonus Rounds” that alter the standard gameplay.

The ETGT system tracks when a player enters these special modes and flags them as eligible for Mystery Jackpot participation for a set duration or number of rounds after activation. The special modes may require additional buy-ins, higher minimum bets, or may be triggered by certain in-game events. This implementation adds an extra layer of excitement to the base game and gives players more control over their jackpot eligibility.

Benefits to Players: Players benefit from this system by having the opportunity to experience varied and exciting gameplay while simultaneously increasing their chances of winning a Mystery Jackpot. The special game modes offer a break from standard play, potentially with different rules or payout structures, keeping the gaming experience fresh and engaging. Players also have a clear path to jackpot eligibility, encouraging strategic decisions about when to activate these modes.

Benefits to Casinos: For casinos, this criterion may drive increased play and higher bet amounts as players opt into special modes. It encourages players to engage with a wider range of game features, potentially increasing time on device and overall revenue. The varied game modes may also attract different player types, broadening the appeal of the ETGTs. Additionally, it provides casinos with valuable data on player preferences for different game styles and risk levels.

Example Walk-through Scenario: Sarah approaches a roulette ETGT and begins playing standard games. After a few rounds, a notification appears: “Try our ‘Speed Roulette’ mode! 2× faster gameplay and Mystery Jackpot eligibility for the next 30 minutes!”

Intrigued, Sarah opts in. The game pace quickens, with less time between spins. A timer appears, showing her Mystery Jackpot eligibility countdown. Sarah finds the faster pace exhilarating and notices she's placing more bets than usual.

Fifteen minutes into Speed Roulette, the ETGT suddenly lights up. “Congratulations, Sarah! You've won a $500 Mystery Jackpot!” Sarah realizes that if she hadn't opted into the special mode, she wouldn't have been eligible for this win.

As her 30 minutes of eligibility near an end, Sarah is prompted to continue in Speed Mode or try a different special mode like “High Roller Roulette” to maintain her jackpot eligibility. Excited by her previous win, Sarah decides to continue playing, now actively seeking out different game modes to stay eligible for more Mystery Jackpot opportunities.

Example System Procedural Flow:
1. Player begins standard gameplay on ETGT
2. ETGT system offers special game mode option
3. Player opts into special mode
4. ETGT adjusts gameplay parameters and notifies central server
5. Central server flags player as eligible for Mystery Jackpot
6. ETGT displays eligibility status and countdown
7. Central server continuously checks for Mystery Jackpot trigger conditions
8. If triggered, server verifies player's continued eligibility
9. ETGT receives win signal and initiates celebration sequence
10. Central server updates jackpot amount and player's win history
11. ETGT prompts player to continue special mode or try different modes
12. System repeats process, maintaining or updating eligibility status

Noteworthy Aspects and Features: This eligibility criterion introduces dynamic gameplay as a factor in Mystery Jackpot participation, which is a novel approach compared to traditional systems. It creates a more interactive and customizable player experience, allowing individuals to tailor their gameplay style while pursuing jackpot opportunities. The time-limited nature of the eligibility adds urgency and excitement to each gaming session.

The system's ability to offer various game modes provides a platform for casinos to continuously innovate and introduce new variations, keeping the gaming experience fresh for regular players. It also opens up possibilities for themed or seasonal game modes tied to specific jackpot events, enhancing the casino's promotional capabilities.

### Eligibility Criteria 14—Seasonal Event Participation

Description and Implementation: This eligibility criterion is based on players playing during special casino events, such as holiday promotions, to qualify for Mystery Jackpot awards. The Electronic Table Game Terminal (ETGT) system is programmed to recognize specific date ranges or event periods designated by the casino. During these periods, all players actively engaged in gameplay on the ETGTs become eligible for special seasonal Mystery Jackpots.

The implementation involves setting up a calendar of events in the central casino management system, which communicates with all ETGTs. When a designated event period is active, the ETGTs display special themed graphics and inform players of their automatic eligibility for the seasonal Mystery Jackpot. This system may be further enhanced by offering themed game variations or special side bets unique to each seasonal event.

Benefits to Players: Players benefit from this system through increased excitement and reward opportunities during special events. It adds an extra layer of anticipation to their casino visits during holidays or promotional periods. Players also appreciate the automatic eligibility, as it doesn't may require any additional action or bet on their part beyond normal play. The seasonal themes may enhance the overall gaming experience, making visits during these periods more memorable.

Benefits to Casinos: For casinos, this criterion provides a powerful tool for driving traffic during specific periods. It may help boost attendance during traditionally slower periods or maximize revenue during peak seasons. The system allows for flexible marketing strategies, with the ability to quickly implement or modify promotional periods. It also encourages player loyalty, as regular players may plan their visits around these special event periods to maximize their chances of winning larger jackpots.

Example Walk-through Scenario: It's December 20th, and the casino has designated December 15-31 as the “Holiday Jackpot Spectacular” period. Tom enters the casino and approaches a blackjack ETGT. As he sits down, the screen displays festive graphics and a message: “Welcome to our Holiday Jackpot Spectacular! All players are eligible for hourly Mystery Jackpot draws. Current Jackpot: $25,000!”

Excited by this unexpected opportunity, Tom begins playing. Between hands, the ETGT displays a countdown to the next hourly jackpot draw. Tom notices that the dealer's virtual avatar is wearing a Santa hat, adding to the festive atmosphere.

After playing for 45 minutes, a bell sound plays across all ETGTs, and an animation of snow falling appears on Tom's screen. Suddenly, his screen lights up: “Congratulations, Tom! You've won our 2 PM Holiday Mystery Jackpot of $5,000!”

Tom is thrilled with his win and appreciates that he didn't have to do anything special to be eligible. He decides to return to the casino a few more times before the end of the month, hoping to catch another Holiday Jackpot before the promotion ends.

Example System Procedural Flow:
1. Casino management sets up seasonal event in central system
2. System pushes event parameters to all connected ETGTs
3. ETGTs update interfaces with seasonal theme and jackpot information
4. Player begins gameplay on ETGT during event period
5. ETGT recognizes active play and flags player as eligible
6. Central system runs periodic Mystery Jackpot draws
7. If a jackpot is triggered, system randomly selects from all eligible players
8. Winning ETGT receives signal and initiates win sequence
9. Central system updates jackpot amount and prepares for next draw
10. ETGTs display updated jackpot information and time to next draw
11. Process repeats throughout the designated event period
12. At end of event, system resets to standard Mystery Jackpot parameters

Noteworthy Aspects and Features: This eligibility criterion introduces a dynamic, time-based element to Mystery Jackpot systems that may be synchronized across an entire casino or even multiple properties. It allows for the creation of a shared, exciting atmosphere during special periods, enhancing the overall casino experience. The system's flexibility enables casinos to react quickly to market conditions, instantly rolling out promotions to drive business during unexpected lulls.

The automatic eligibility feature is particularly novel, as it removes barriers to participation and ensures all active players have a chance to win. This inclusivity may significantly boost player satisfaction and engagement. Additionally, the ability to theme both the jackpots and the game interfaces opens up creative possibilities for immersive, season-specific gaming experiences.

### Eligibility Criteria 15—Location-Based Participation

Description and Implementation: This eligibility criterion makes players in specific areas of the casino, such as VIP lounges or high-limit rooms, exclusively eligible for certain Mystery Jackpot awards. The implementation involves integrating the Electronic Table Game Terminals (ETGTs) with the casino's floor management system and potentially utilizing indoor positioning technology.

ETGTs in designated areas are programmed to offer exclusive Mystery Jackpot opportunities. These may be higher-value jackpots, more frequent draws, or themed jackpots specific to that area. The system uses a combination of ETGT location data and player tracking to ensure only players in the specified areas are eligible for these exclusive jackpots.

Benefits to Players: Players benefit from this system through access to exclusive jackpot opportunities in premium areas of the casino. It adds value to playing in VIP or high-limit sections, beyond just higher betting limits. For players who enjoy a more exclusive atmosphere, this system provides additional incentive to use these areas. It may also create a sense of progression for players, as they gain access to better jackpot opportunities as they move to higher-tier areas.

Benefits to Casinos: For casinos, this criterion provides a powerful tool for managing floor traffic and encouraging play in specific areas. It may be used to drive traffic to underutilized sections of the casino or to enhance the appeal of premium areas. This system also allows for more targeted marketing, with jackpots tailored to the preferences of players in different areas. It may significantly enhance the perceived value of VIP or high-limit areas, potentially driving more players to seek access to these exclusive sections.

Example Walk-through Scenario: Lisa, a high-roller, enters the casino's VIP room and approaches a baccarat ETGT. As she sits down, the screen welcomes her and displays a message: “Exclusive VIP Room Mystery Jackpot now active. Current amount: $50,000. Draws every 30 minutes!”

As Lisa plays, she notices the jackpot amount is significantly higher than in the main casino area. Between hands, the ETGT displays a countdown to the next draw, building anticipation. After about 20 minutes of play, all ETGTs in the VIP room light up, and a voice announces: “VIP Mystery Jackpot draw in progress!”

Moments later, Lisa's screen erupts in celebration. “Congratulations! You've won the VIP Mystery Jackpot of $50,000!” Lisa is ecstatic, realizing that her decision to play in the VIP room gave her access to this exclusive jackpot opportunity.

Energized by her win, Lisa continues to play, noting that the next exclusive VIP jackpot draw is already accumulating. She appreciates the added value of playing in this section of the casino and decides to spend more of her gaming time in the VIP area in the future.

### Example System Procedural Flow:

1. Casino defines exclusive jackpot areas in central management system
2. System configures ETGTs in designated areas with exclusive jackpot parameters
3. Player enters exclusive area and begins play on ETGT
4. ETGT recognizes its location and applicable exclusive jackpot
5. Player is automatically flagged as eligible for exclusive jackpot
6. Central system manages separate jackpot pools for different areas
7. System initiates periodic jackpot draws for each exclusive area
8. If jackpot is triggered, system selects winner from eligible players in that area
9. Winning ETGT receives signal and initiates win sequence
10. Central system updates area-specific jackpot amount
11. All ETGTs in the area update displayed jackpot information
12. Process continues with area-specific jackpot pools operating independently

Noteworthy Aspects and Features: This eligibility criterion introduces a sophisticated layer of location-based gaming that goes beyond traditional player tracking. It allows for the creation of micro-environments within the casino, each with its own unique jackpot ecosystem. This level of customization is novel in the industry and provides numerous opportunities for creative marketing and player engagement strategies.

The system's ability to operate multiple, independent jackpot pools simultaneously across different areas is particularly innovative. It allows for fine-tuned control over jackpot frequencies and amounts, tailored to the specific player demographics of each area. This may be especially powerful in optimizing the balance between jackpot appeal and casino profitability in different sections of the gaming floor.

Furthermore, this system may be expanded to create dynamic “hot spots” on the casino floor, with temporary jackpot zones that move throughout the day, driving traffic to different areas as needed. This adds an element of discovery and excitement for players as they explore the casino floor.

### Eligibility Criteria 16—Participation in Tournament Mode

Description and Implementation: This eligibility criterion is based on players participating in a tournament format on Dealer-controlled Electronic Table Games (DETGs) to become eligible for Mystery Jackpot awards. The implementation involves configuring the DETGs to offer scheduled or on-demand tournament modes alongside regular play. When in tournament mode, participating players are not only competing against each other but are also eligible for special tournament-specific Mystery Jackpots.

The system tracks tournament participation and progress, with players becoming eligible for Mystery Jackpot draws at various stages of the tournament (e.g., upon reaching certain point thresholds, advancing to new rounds, or simply based on duration of participation). This creates a dual reward structure where players may win both the tournament prizes and Mystery Jackpots.

Benefits to Players: Players benefit from this system through increased excitement and reward potential during tournament play. It adds an extra layer of anticipation to the competitive tournament environment. Players appreciate the opportunity to potentially win large jackpots in addition to tournament prizes, making tournament participation more attractive. The tournament format also allows players to compete directly against others while still having individual chances at Mystery Jackpots, appealing to both competitive and luck-oriented gainers.

Benefits to Casinos: For casinos, this criterion provides a powerful tool for driving engagement in tournament events. It may help boost participation in scheduled tournaments and encourage the formation of impromptu tournaments during slower periods. The system allows for flexible tournament structures, from short, frequent events to longer, high-stakes competitions, all with integrated Mystery Jackpot potential. It also encourages longer play sessions as players strive to maintain their tournament standing and jackpot eligibility.

Example Walk-through Scenario: The casino announces a weekend-long blackjack tournament on its DETGs. Mark signs up, excited by both the competition and the advertised tournament-specific Mystery Jackpots. As he takes his seat at a DETG, the screen displays his tournament stats and a message: “Tournament Mystery Jackpots active! Eligible for draws every 100 hands played.”

Mark begins playing, focusing on his tournament strategy while keeping an eye on his hand count. After his 95th hand, anticipation builds. On his 100th hand, regardless of the blackjack outcome, the screen flashes: “Mystery Jackpot Eligibility Achieved!” A separate window appears, showing a rapid draw of numbers.

Suddenly, celebratory music plays. “Congratulations, Mark! You've won a $1,000 Tournament Mystery Jackpot!” Mark is thrilled, realizing he's won this jackpot on top of his current tournament standings. The win energizes him, and he continues playing with renewed enthusiasm.

As the tournament progresses, Mark notices different Mystery Jackpot opportunities appearing: some based on chip stack milestones, others for advancing to new rounds. This keeps him engaged even when his tournament performance fluctuates, always giving him something extra to strive for.

### Example System Procedural Flow:

1. Casino sets up tournament parameters in central system, including Mystery Jackpot rules
2. Players register for tournament at DETGs or through casino staff
3. At tournament start, DETGs switch to tournament mode with special interface
4. System tracks each player's tournament progress and jackpot eligibility factors
5. As players reach predetermined milestones, system flags them for jackpot eligibility
6. Central system runs Mystery Jackpot draws at set intervals or trigger points
7. If a jackpot is hit, system verifies current eligibility of selected player
8. Winning DETG receives signal and initiates win sequence
9. Tournament leaderboard and player stats are updated to reflect jackpot win
10. System resets for next jackpot draw while tournament continues
11. Process repeats throughout the tournament duration
12. At tournament end, final ranks are calculated, factoring in any jackpot wins

Noteworthy Aspects and Features: This eligibility criterion introduces a novel blend of tournament competition and random jackpot opportunity, creating a unique gaming experience. The integration of Mystery Jackpots into the tournament structure adds a layer of unpredictability and excitement that may keep players engaged even if they're not top contenders in the main tournament.

The system's ability to offer varied jackpot triggers based on different tournament milestones is particularly innovative. It allows for a dynamic reward structure that may adapt to different tournament formats and durations. This flexibility may be used to create highly customized and themed tournament experiences.

Moreover, this system opens up possibilities for multi-tiered tournaments where Mystery Jackpot wins may influence tournament standings or provide entry into higher-stakes rounds. The combination of skill-based competition and luck-based jackpots caters to a wide range of player preferences, potentially attracting both serious gamblers and more casual players to tournament events.

### Eligibility Criteria 17—Frequency of Play

Description and Implementation: This eligibility criterion is based on players who meet a certain threshold of hands dealt (e.g., 100 hands within an hour) to become eligible for Mystery Jackpot awards. The implementation involves the Dealer-controlled Electronic Table Game (DETG) system tracking the number of hands played by each player within a specified time frame.

The DETG continuously monitors the pace of play for each player, counting the number of hands they participate in. When a player reaches the predetermined threshold, they are automatically flagged as eligible for the Mystery Jackpot. This eligibility may be designed to last for a set duration (e.g., the next hour) or until the end of their current gaming session. The system may also incorporate tiered eligibility, where playing more hands increases the chances of winning or unlocks access to larger jackpots.

Benefits to Players: Players benefit from this system through a clear, achievable goal for jackpot eligibility that rewards consistent play. It adds an extra layer of excitement to each gaming session, as players strive to reach the hand threshold. The system also provides a sense of accomplishment and increased value for time spent at the table. For players who enjoy faster-paced games, this criterion aligns well with their preferred style of play.

Benefits to Casinos: For casinos, this criterion encourages more hands played per hour, potentially increasing overall revenue. It incentivizes players to maintain a steady pace of play and may help reduce idle time at tables. The system also provides valuable data on player behavior and game speed, which may be used to optimize table management and staffing. Additionally, it may help identify and reward loyal, frequent players, potentially increasing customer retention.

Example Walk-through Scenario: Emily sits down at a DETG poker table and begins playing. A notification appears: “Play 100 hands in the next hour to qualify for our $10,000 Mystery Jackpot!” Intrigued, Emily decides to focus on her game, noting a hand counter that has appeared on her screen.

As Emily plays, she sees the counter incrementing with each hand. The pace is challenging but achievable, adding an extra thrill to each deal. After 45 minutes and 80 hands, a message encourages her: “Only 20 more hands in 15 minutes to qualify!”

Energized, Emily continues playing. With just two minutes left, she reaches her 100th hand. The screen celebrates her achievement: “Congratulations! You're now eligible for the Mystery Jackpot for the next hour!”

For the next hour, Emily plays with heightened anticipation. Every hand may trigger the Mystery Jackpot. Thirty minutes in, the DETG suddenly lights up with flashing graphics. “You've won the $10,000 Mystery Jackpot!” Emily is ecstatic, realizing her consistent play not only made her eligible but also led to a significant win.

### Example System Procedural Flow:

1. Player begins session at DETG
2. System initializes hand counter and timer for the player
3. DETG tracks each hand played by the player
4. System continuously updates hand count and checks against time
5. If threshold is reached within time limit, player is flagged as eligible
6. DETG notifies player of achieved eligibility status
7. Central system includes player in Mystery Jackpot draws
8. If jackpot is triggered, system verifies player's continued eligibility
9. Winning DETG receives signal and initiates celebration sequence
10. System resets eligibility timer and hand counter for next period
11. Player's eligibility is maintained or updated based on continued play
12. Process repeats, encouraging consistent gameplay

Noteworthy Aspects and Features: This eligibility criterion introduces a dynamic, time-based element to Mystery Jackpot systems that directly rewards player engagement and frequency of play. It's a novel approach that ties jackpot eligibility to measurable player activity rather than purely random chance or bet amounts.

The system's ability to adapt to different game types and casino preferences is particularly innovative. Casinos may adjust the hand threshold and time frame to suit different games or player demographics, optimizing for both player enjoyment and casino profitability.

Furthermore, this system may be expanded to include progressive eligibility tiers, where players unlock access to larger jackpots or better odds as they play more hands. This creates a sense of progression and achievement within a single gaming session, potentially extending play times and increasing player satisfaction.

### Eligibility Criteria 18—Play On Specific Terminals

Description and Implementation: This eligibility criterion is based on players using specially marked or promotional terminals (e.g., promotional “lucky” machines) to become eligible for Mystery Jackpot awards. The implementation involves designating certain Dealer-controlled Electronic Table Game (DETG) terminals as special jackpot-eligible machines, either permanently or for specific promotional periods.

These special DETGs are clearly marked with distinctive signage, lighting, or on-screen graphics to attract players. The central casino management system recognizes these terminals and applies unique Mystery Jackpot rules to players using them. This may include exclusive jackpots only available on these machines, increased odds of winning existing jackpots, or special jackpot multipliers.

Benefits to Players: Players benefit from this system through access to exclusive or enhanced jackpot opportunities on specific machines. It adds an element of strategy to choosing which DETG to play, as players weigh the potential for larger or more frequent jackpots against factors like game type or table limits. The clearly marked special terminals create a sense of excitement and opportunity, enhancing the overall gaming experience.

Benefits to Casinos: For casinos, this criterion provides a powerful tool for managing floor traffic and promoting specific games or areas. It allows for targeted promotion of new games or underutilized sections of the casino floor. The system also creates opportunities for rotating promotions, keeping the gaming floor dynamic and encouraging players to explore different areas. Additionally, it may be used to test player preferences for different jackpot structures or game variations.

Example Walk-through Scenario: Tom enters the casino and notices a group of DETGs with flashing “Lucky Jackpot Terminal” signs. Curious, he approaches and sees a message on the screen: “Play here for exclusive access to our $50,000 Mega Mystery Jackpot!”

Excited by the opportunity, Tom sits down and begins playing blackjack. The interface includes a special Mega Mystery Jackpot meter not seen on other machines. As he plays, Tom notices the jackpot incrementing faster than usual, adding to his anticipation.

After an hour of play, the DETG suddenly comes alive with lights and sounds. The screen displays a massive celebration animation: “Congratulations! You've won the exclusive $50,000 Mega Mystery Jackpot!”

Tom is overjoyed, realizing his choice to play on this special terminal led to a life-changing win. As he celebrates, he notices other players moving towards the remaining “Lucky Jackpot Terminals,” eager for their own chance at the exclusive jackpot.

### Example System Procedural Flow:

1. Casino designates specific DETGs as special jackpot terminals
2. Central system configures these terminals with unique jackpot parameters
3. Player begins gameplay on a special jackpot DETG
4. System recognizes terminal's special status and applies relevant rules
5. Player is automatically eligible for exclusive or enhanced jackpots
6. Central system manages separate jackpot pools for special terminals
7. System runs jackpot draws, with adjusted odds for special terminals
8. If jackpot is triggered, system verifies it's for a special terminal
9. Winning DETG receives signal and initiates enhanced win sequence
10. Central system updates jackpot amount for special terminals
11. All special DETGs update displayed jackpot information
12. Process continues, maintaining separate jackpot ecosystem for special terminals

Noteworthy Aspects and Features: This eligibility criterion introduces a novel way to create “hot spots” on the casino floor, driving traffic and excitement to specific areas or games. It allows for a level of dynamism in floor management that is not typically seen in traditional casino setups. The ability to quickly designate and re-designate special jackpot terminals provides casinos with a flexible tool for responsive floor management.

The system's capacity to offer entirely separate jackpot ecosystems for these special terminals is particularly innovative. It allows casinos to experiment with different jackpot structures or sizes without affecting their main jackpot offerings. This may be especially useful for introducing new games or betting structures, providing an additional incentive for players to try them out.

Furthermore, this system may be expanded to create themed clusters of special terminals, each with their own unique jackpot characteristics. For example, a “High Roller Corner” with larger, less frequent jackpots, or a “Quick Win Zone” with smaller, more frequent payouts. This level of customization and theming may significantly enhance the casino's ability to cater to different player preferences and create diverse gaming experiences within the same floor space.

### Eligibility Criteria 19—Game Skill Achievement

Description and Implementation: This eligibility criterion is based on players who achieve certain in-game accomplishments, such as a perfect blackjack hand or a streak of winning hands, to qualify for Mystery Jackpot eligibility. The implementation involves programming the Dealer-controlled Electronic Table Game (DETG) system to recognize and track specific gameplay achievements across various casino games.

The system monitors each player's performance in real-time, looking for predetermined skill-based milestones. These may include achieving a certain number of consecutive wins, completing a specific hand combination, or maintaining a high win rate over a set number of hands. When a player reaches one of these achievements, they are automatically flagged as eligible for the Mystery Jackpot, either for a set duration or for the remainder of their gaming session.

Benefits to Players: Players benefit from this system through recognition and reward for skilled play. It adds an extra layer of excitement and accomplishment to the gaming experience, beyond just monetary wins. The system appeals to players who pride themselves on their gaming skills and strategies. It also provides an additional goal to strive for during play, potentially extending gaming sessions and increasing overall enjoyment.

Benefits to Casinos: For casinos, this criterion encourages players to engage more deeply with the games, potentially leading to longer play sessions. It may attract skilled players who may otherwise be less interested in random jackpots. The system also provides valuable data on player skill levels and game mastery, which may be used for marketing and game development. Additionally, it creates opportunities for casinos to promote skill-based gaming within the context of traditional chance-based games.

Example Walk-through Scenario: Sarah, an experienced blackjack player, sits down at a DETG. She notices a section on the screen labeled “Skill Achievements” with various milestones listed. One catches her eye: “Win 5 hands in a row to unlock Mystery Jackpot eligibility !”

Intrigued, Sarah begins playing with renewed focus. She wins her first three hands and feels the excitement building. On her fourth hand, she's dealt a challenging 16 against the dealer's 10. Sarah decides to hit, receives a 5, and wins the hand. The excitement is palpable as she enters her fifth hand.

Sarah is dealt an 11 against the dealer's 6. She doubles down and receives a 10, winning her fifth consecutive hand. The screen erupts in celebration: “Congratulations on 5 consecutive wins! You're now eligible for the $25,000 Mystery Jackpot for the next hour!”

For the next hour, Sarah plays with added anticipation. Every hand may potentially trigger the Mystery Jackpot. Halfway through, the DETG suddenly announces, “Mystery Jackpot Winner!” Sarah has won $5,000, a reward not just for luck, but for her skilled play.

### Example System Procedural Flow:

1. Player begins session at DETG
2. System initializes tracking for various skill achievements
3. DETG monitors each game outcome and player decisions
4. System continuously updates achievement progress
5. When a skill milestone is reached, player is flagged as eligible
6. DETG notifies player of achieved eligibility status
7. Central system includes player in Mystery Jackpot draws
8. If jackpot is triggered, system verifies player's eligibility
9. Winning DETG receives signal and initiates celebration sequence
10. System resets or updates achievement trackers
11. Player's eligibility is maintained or updated based on continued skilled play
12. Process repeats, encouraging skillful gameplay

Noteworthy Aspects and Features: This eligibility criterion introduces a novel blend of skill-based gaming and random jackpots, creating a unique gaming experience that appeals to both strategic players and those seeking big wins. It's an innovative approach that rewards player skill within the framework of traditional casino games, potentially attracting a broader range of players.

The system's ability to recognize and reward various types of in-game achievements across different casino games is particularly noteworthy. This flexibility allows casinos to create a diverse range of skill-based challenges, keeping the gaming experience fresh and engaging for regular players.

Furthermore, this system may be expanded to include a tiered achievement system, where reaching higher skill levels unlocks access to larger jackpots or better odds. This creates a sense of progression and mastery, potentially increasing player engagement and loyalty. The data gathered from tracking these skill achievements may also be used to create personalized challenges or tournaments, further enhancing the gaming experience.

### Eligibility Criteria 20—Cross-Casino Play

Description and Implementation: This eligibility criterion is based on players who participate at Electronic Table Game Terminals (ETGTs) in different casino properties under the same brand (within a time frame) to become eligible for Mystery Jackpot awards. The implementation involves creating a networked system that links ETGTs across multiple casino properties, tracking player activity across these locations.

The system uses player tracking cards or digital identifiers to recognize when a player engages in gaming activities at different properties. It sets specific criteria, such as playing at a minimum number of different locations within a set time period (e.g., three different casinos in a month), or accumulating a certain amount of play time across multiple properties. Once a player meets these criteria, they become eligible for special cross-property Mystery Jackpots.

Benefits to Players: Players benefit from this system through increased rewards for their loyalty across multiple properties. It adds an element of adventure and exploration to their gaming experience, encouraging them to visit different locations. The system provides a sense of progression and achievement as players work towards eligibility by visiting various properties. It also offers the excitement of potentially larger, multi-property jackpots that wouldn't be possible at a single location.

Benefits to Casinos: For casino groups, this criterion drives cross-property traffic and encourages players to explore different locations. It may help balance attendance across properties and promote less-visited locations. The system also provides valuable data on player travel patterns and preferences, which may be used for targeted marketing and property development. Additionally, it strengthens brand loyalty by creating a unified gaming experience across multiple locations.

Example Walk-through Scenario: Mark is a member of a casino group with properties in Las Vegas, Atlantic City, and Macau. During a business trip to Las Vegas, he plays at the local property's ETGTs and notices a promotion: “Play at 3 of our properties in 6 months to qualify for our $5 Million Global Mystery Jackpot!”

Intrigued, Mark makes sure to visit the Atlantic City location during a weekend getaway two months later. As he sits at an ETGT, the screen welcomes him and notes: “⅔ properties visited for Global Mystery Jackpot eligibility!”

Four months after his first visit, Mark vacations in Macau and visits the casino there. As he inserts his player card into an ETGT, the screen lights up: “Congratulations! You've now played at 3 properties and are eligible for the $5 Million Global Mystery Jackpot!”

Excited by this achievement, Mark begins playing. An hour into his session, the ETGT suddenly comes alive with an elaborate animation. “Unbelievable! You've won the $5 Million Global Mystery Jackpot!” Mark is ecstatic, realizing his global gaming adventure has led to a life-changing win.

### Example System Procedural Flow:

1. Player engages in gameplay at an ETGT in any networked property
2. System recognizes player through tracking card or digital ID
3. Central database updates player's cross-property activity log
4. System checks if player meets multi-property play criteria
5. If criteria are met, player is flagged as eligible for global jackpot
6. All networked ETGTs recognize player's eligibility status
7. Central system manages global jackpot pool across all properties
8. System runs global jackpot draws for eligible players
9. If jackpot is triggered, winning property and ETGT are notified
10. Winning ETGT initiates celebration sequence
11. Central system updates global jackpot amount across all properties
12. Process continues, maintaining global player eligibility and jackpot

Noteworthy Aspects and Features: This eligibility criterion introduces a novel way to create a unified gaming experience across geographically dispersed properties. It's an innovative approach to leveraging a casino group's multiple locations as a unique selling point, creating a global gaming adventure for players. The system's ability to track and reward multi-property play in real-time is particularly noteworthy, as it creates a seamless experience for players regardless of location.

The potential for creating truly massive, multi-property jackpots is a significant innovation. These global jackpots may reach sizes that would be difficult or impossible for single properties to support, creating a major draw for players. This may position casino groups to compete more effectively with large-scale lotteries and online gaming platforms.

Furthermore, this system opens up possibilities for creative, geography-based promotions. For example, special jackpots for playing in all properties in a certain region, or themed global jackpots tied to international events or seasons. The data gathered from cross-property play may also be used to create personalized travel packages or recommendations, enhancing the overall customer experience beyond just gaming.

### Eligibility Criteria 21—Social Media Promotion

Description and Implementation: This eligibility criteria leverages social media engagement to determine player eligibility for Mystery Jackpot awards at live dealer game tables (LDGTs) and live Dealer-controlled Electronic Table Games systems (DETGs). Players who engage with the casino's social media campaigns, such as checking in at the casino, sharing game stats, or posting about their experience, may become eligible for the Mystery Jackpot. This innovative approach integrates digital marketing with on-site gaming experiences, creating a seamless connection between online presence and in-casino rewards.

Implementation involves linking players' social media accounts to their casino player profiles. The DETG system interfaces with a social media API to track player interactions in real-time. When a player performs a qualifying social media action, such as using a specific hashtag or sharing a post from the casino's page, the system flags their account for Mystery Jackpot eligibility. This flag remains active for a predetermined period, such as 24 hours from the time of the social media interaction.

### Benefits to Players:

Increased chances of winning Mystery Jackpots through simple social media actions
Enhanced gaming experience by integrating social sharing with potential rewards
Opportunity to showcase their gaming achievements to friends and followers

### Benefits to Casinos:

Amplified social media presence and organic marketing through player-generated content
Increased player engagement both online and on the casino floor
Valuable data collection on player behavior and preferences across platforms

Example Walk-through Scenario: Sarah, a regular at Galaxy Macau, arrives at the casino for an evening of baccarat. Before starting her game session, she opens her Instagram app and checks in at the casino using the official hashtag #GalaxyMacauNights. The casino's social media monitoring system detects this action and sends a notification to the DETG system.

As Sarah approaches a DETG terminal, she inserts her player card. The system recognizes her and cross-references her recent social media activity. A message appears on the terminal screen: “Welcome back, Sarah! Your recent social media check-in has activated your Mystery Jackpot eligibility for the next 24 hours. Good luck!”

Excited by this unexpected bonus, Sarah begins playing baccarat. Throughout her session, she's aware that any hand may trigger the Mystery Jackpot. After a particularly good win, Sarah decides to share her success. She uses the DETG's built-in social sharing feature to post her win stats directly to her Facebook page. This action refreshes her Mystery Jackpot eligibility for another 24 hours.

As Sarah continues playing, the Mystery Jackpot is randomly triggered. Because of her active social media engagement, Sarah is included in the pool of eligible players. The system selects her as the winner, and she's thrilled to see the Mystery Jackpot announcement flash across her screen. The casino staff congratulates her, and Sarah immediately shares her jackpot win on social media, further promoting the casino's Mystery Jackpot feature to her followers.

### Example System Procedural Flow:

1. Player logs into social media account and performs a qualifying action (e.g., check-in, post sharing).
2. Casino's social media monitoring system detects the action and sends data to the central casino management system.
3. Central system updates player's profile with a “social media engagement” flag and timestamp.
4. Player arrives at DETG and inserts player card or logs in.
5. DETG system queries central database for player information, including social media engagement status.
6. System confirms player's Mystery Jackpot eligibility based on recent social media activity.
7. DETG displays eligibility status to player and activates Mystery Jackpot participation for the session.
8. During gameplay, system continuously checks for Mystery Jackpot trigger events.
9. If Mystery Jackpot is triggered, system includes player in the selection pool due to eligibility.
10. If player wins, system notifies casino staff and updates player's account with winnings.
11. System prompts player to share win on social media, potentially extending eligibility.
12. Casino management system records all data for analytics and future promotional planning.

Noteworthy Aspects and Features: This eligibility criteria introduces a novel integration of social media engagement with live casino gaming, creating a unique synergy between online and offline experiences. It leverages the power of user-generated content and social proof to enhance the casino's marketing efforts while providing tangible benefits to players. The real-time nature of the eligibility activation adds an element of immediacy and excitement to the gaming experience.

The system's ability to track and respond to social media actions in real-time demonstrates advanced integration capabilities between disparate systems (social media platforms, casino management software, and DETG systems). This level of integration is particularly innovative in the traditionally separated worlds of social media and casino gaming.

Moreover, the cyclical nature of the promotion—where winning encourages sharing, which in turn extends eligibility—creates a self-reinforcing loop of engagement that benefits both players and the casino. This approach not only incentivizes social media interaction but also turns players into brand ambassadors, potentially reaching new audiences and driving foot traffic to the casino.

The flexibility of this system allows for easy adaptation to various social media platforms and changing trends, ensuring the promotion remains relevant and engaging over time. This adaptability, combined with the data collection opportunities it presents, makes this eligibility criteria a powerful tool for casinos to enhance their marketing strategies and player retention efforts.

### Eligibility Criteria 22—Cumulative Play Time

Description and Implementation: This eligibility criteria focuses on rewarding players for their sustained engagement with the casino's live dealer game tables (LDGTs) and live Dealer-controlled Electronic Table Games systems (DETGs) based on their total cumulative play time. Players whose total play time across all games at the casino exceeds a predetermined threshold, such as 10 hours, become eligible for Mystery Jackpot awards. This approach incentivizes longer gaming sessions and frequent visits, fostering a deeper connection between the player and the casino.

Implementation involves sophisticated player tracking systems integrated with the DETGs and LDGTs. Each time a player begins a gaming session by logging into a terminal or sitting at a table, the system starts tracking their play time. This time is continuously accumulated across multiple sessions and games, providing a comprehensive view of the player's engagement with the casino. The tracking system is designed to handle interruptions gracefully, such as short breaks or switching between games, ensuring accurate time calculation.

### Benefits to Players:

Rewards loyalty and consistent play without requiring large wagers
Provides an additional incentive for extended play sessions
Offers a sense of progress towards a tangible goal (Mystery Jackpot eligibility)

### Benefits to Casinos:

Encourages longer play sessions and more frequent visits
Increases player retention and lifetime value
Provides valuable data on player behavior and preferences over time

Example Walk-through Scenario: John is a regular visitor to City of Dreams Macau. Over the past week, he has played various games at the casino's DETGs, including baccarat, roulette, and blackjack. Each time he plays, he uses his player card to log in, allowing the system to track his play time accurately.

On his latest visit, John approaches a DETG terminal and inserts his player card. The screen displays a welcome message along with his current cumulative play time: “Welcome back, John! Your total play time is 9 hours and 45 minutes. Play for 15 more minutes to unlock Mystery Jackpot eligibility!”

Excited by the prospect, John decides to play blackjack. As he plays, a small timer in the corner of the screen shows his current session time adding to his total. After 20 minutes of play, a notification appears: “Congratulations, John! You've reached 10 hours of total play time. You are now eligible for Mystery Jackpot awards!”

Throughout his gaming session, John notices periodic reminders of his Mystery Jackpot eligibility. This encourages him to continue playing, knowing that each hand may potentially trigger a significant win. After a few hours, John decides to take a break. The system pauses his time tracking but retains his Mystery Jackpot eligibility.

When John returns the next day, the system welcomes him back and informs him that his Mystery Jackpot eligibility is still active due to his cumulative play time. This recognition of his consistent play enhances John's gaming experience and strengthens his loyalty to City of Dreams Macau.

### Example System Procedural Flow:

1. Player logs into a DETG terminal using their player card.
2. System retrieves player's historical play time data from the central database.
3. DETG displays current cumulative play time and time remaining to reach eligibility threshold.
4. System begins tracking current session play time, adding it to the cumulative total in real-time.
5. When the cumulative play time reaches the predetermined threshold, system flags player as eligible for Mystery Jackpot.
6. System sends notification to the DETG terminal, informing the player of their new eligibility status.
7. Mystery Jackpot eligibility status is stored in the central database and shared across all connected DETGs and LDGTs.
8. During gameplay, system continuously checks for Mystery Jackpot trigger events.
9. If Mystery Jackpot is triggered, system includes player in the selection pool due to eligibility.
10. If player wins, system notifies casino staff and updates player's account with winnings.
11. System continues tracking play time, potentially for higher tier eligibility or to maintain current status.
12. Play time data is regularly analyzed for player behavior insights and to adjust eligibility thresholds if needed.

Noteworthy Aspects and Features: This eligibility criteria introduces a novel approach to rewarding player loyalty based on time investment rather than solely on wagering amounts. It acknowledges that a player's value to the casino extends beyond their immediate bets to include their consistent presence and engagement. This may be particularly appealing to players who enjoy the social and entertainment aspects of casino gaming but may not always make large wagers.

The real-time tracking and display of cumulative play time create a transparent and engaging progression system for players. It gamifies the casino experience by providing clear goals and immediate rewards for reaching them. This constant feedback loop may significantly enhance player motivation and satisfaction.

Moreover, the system's ability to track play time across multiple games and sessions demonstrates a sophisticated level of integration between various casino systems. This holistic view of player activity allows for more personalized and effective player reward strategies.

The flexibility of this system allows casinos to easily adjust eligibility thresholds based on data analysis and business objectives. For instance, thresholds may be lowered during off-peak hours to encourage play or raised for high-stakes games to create more exclusive jackpot opportunities.

Lastly, this approach provides casinos with a wealth of data on player behavior, including preferred games, play patterns, and visit frequency. This information may be invaluable for tailoring marketing strategies, optimizing game offerings, and enhancing overall casino operations.

### Eligibility Criteria 23—Biggest Loss Rebate

Description and Implementation: This innovative eligibility criteria aims to provide a safety net for players who experience significant losses within a specific time window, making them eligible for a Mystery Jackpot as a rebate incentive. This approach adds an element of risk mitigation for players while maintaining the excitement of high-stakes play. It's particularly well-suited for high-roller rooms and VIP areas in premium casinos like those found in Macau.

Implementation may require sophisticated real-time tracking of player losses across all LDGTs and DETGs within the casino. The system continuously monitors each player's net losses over a predetermined period (e.g., 24 hours, 7 days). When a player's net loss reaches a certain threshold or becomes the largest among all players within the specified time frame, they automatically become eligible for the Mystery Jackpot.

### Benefits to Players:

Provides a “second chance” opportunity after significant losses
Reduces the psychological impact of big losses, encouraging continued play
Adds an extra layer of excitement to high-stakes gaming

### Benefits to Casinos:

Encourages higher stakes play by mitigating some of the risk for players
Increases player retention, especially among high-value customers
Creates a unique selling point for the casino's high-roller offerings

Example Walk-through Scenario: Linda, a high-roller visiting Venetian Macao, decides to try her luck at the VIP baccarat tables. She begins her session with a substantial bankroll, prepared for a night of high-stakes gaming. As she plays, the casino's tracking system monitors her wagers and outcomes in real-time.

After several hours of play, Linda finds herself down by a significant amount. Unbeknownst to her, her loss is currently the largest in the casino for the past 24 hours. As she considers whether to continue playing or call it a night, a notification appears on the DETG screen:

“Attention VIP Player: Your recent play has qualified you for our Exclusive Mystery Jackpot Rebate opportunity. Every hand you play for the next hour has a chance to trigger a Mystery Jackpot, potentially offsetting your losses. Good luck!”

Intrigued by this unexpected opportunity, Linda decides to continue playing. The knowledge that she now has a chance at a significant jackpot reinvigorates her enthusiasm for the game. She plays on, her eligibility for the Mystery Jackpot adding an extra layer of anticipation to each hand.

During this period, the Mystery Jackpot is indeed triggered. As the eligible player with the biggest loss, Linda wins a substantial jackpot that significantly offsets her earlier losses. This turn of events not only salvages her gaming session but also reinforces her loyalty to Venetian Macao for providing this unique rebate opportunity.

### Example System Procedural Flow:

1. Player begins gaming session at a DETG or LDGT, logging in with their player card.
2. System begins real-time tracking of player's wagers and outcomes.
3. Central database continuously updates player's net loss/win amount for the current time window.
4. System regularly compares player's net loss to predetermined threshold and to other players' losses.
5. When player's loss becomes the largest or exceeds the threshold, system flags player as eligible for Mystery Jackpot.
6. DETG or LDGT displays notification to player about their new eligibility status.
7. System activates enhanced Mystery Jackpot probability for the eligible player for a set duration.
8. During this period, system continuously checks for Mystery Jackpot trigger events.
9. If Mystery Jackpot is triggered, system confirms player's eligibility and awards the jackpot.
10. System notifies casino staff and updates player's account with jackpot winnings.
11. Player's loss data is reset, and the system begins tracking for the next time window.
12. Analytics team reviews loss patterns and jackpot awards to optimize the rebate system.

Noteworthy Aspects and Features: This eligibility criteria represents a paradigm shift in how casinos approach risk and reward for high-stakes players. By turning the biggest loss into a potential advantage, it creates a unique value proposition that may set a casino apart in the competitive Macau market.

The real-time nature of the loss tracking and eligibility determination showcases the advanced capabilities of modern casino management systems. It may require seamless integration between individual gaming devices, central databases, and analytics engines to function effectively.

This system also demonstrates a keen understanding of player psychology. By offering a “rebate” in the form of jackpot eligibility, it provides a softer and more exciting alternative to traditional loss rebate programs. This may help maintain a positive atmosphere even during losing streaks, potentially extending play sessions and enhancing overall player satisfaction.

The flexibility of the system allows for easy adjustment of thresholds and time windows, enabling casinos to fine-tune the program based on player demographics, time of day, or special events. This adaptability ensures the feature remains effective and engaging over time.

Lastly, this approach provides valuable data on high-stakes play patterns and risk tolerance among top players. This information may be notable for developing targeted marketing strategies, optimizing game offerings, and enhancing VIP services.

### Eligibility Criteria 24—Environmental Trigger Participation

Description and Implementation: This unique eligibility criteria ties Mystery Jackpot participation to specific environmental triggers within the casino, creating an immersive and dynamic gaming experience. Players engaged in gameplay during certain predetermined environmental events, such as a jackpot bell ringing, a light show, or a scheduled performance, become eligible for Mystery Jackpot awards. This approach adds an element of unpredictability and excitement to the casino floor, encouraging players to remain engaged and alert to their surroundings.

Implementation involves integrating the DETG and LDGT systems with the casino's environmental control systems. These may include lighting systems, sound systems, digital signage, and event scheduling software. The casino may program specific triggers to occur at random intervals or at scheduled times. When a trigger event occurs, the system automatically flags all active players on eligible games for Mystery Jackpot participation for a set duration.

### Benefits to Players:

Adds an extra layer of excitement and anticipation to the gaming experience
Provides unexpected opportunities for jackpot eligibility
Encourages awareness and engagement with the broader casino environment

### Benefits to Casinos:

Increases player engagement and time on device
Creates a vibrant and dynamic casino atmosphere
Offers flexible marketing opportunities through controllable trigger events

Example Walk-through Scenario: Michael is enjoying an evening of roulette at a DETG in MGM Macau. As he plays, he notices periodic announcements about environmental trigger events that may activate Mystery Jackpot eligibility. This piques his interest, adding an extra dimension to his gaming experience.

Suddenly, the casino's ambient lighting shifts to a deep blue, and a melodic chime sounds throughout the gaming floor. The DETG screen flashes a message: “Environmental Trigger Activated! All active players are now eligible for the Mystery Jackpot for the next 10 minutes. Good luck!”

Excited by this unexpected opportunity, Michael continues his roulette game with renewed enthusiasm. He notices other players at nearby tables and machines similarly energized by the announcement. The casino floor buzzes with anticipation as everyone hopes to hit the Mystery Jackpot during this special period.

As Michael plays, he keeps an eye on the timer displayed on his DETG screen, showing how long the eligibility period will last. Just as the timer is about to expire, another environmental trigger occurs—this time, a mini light show near the high-limit area. The eligibility period is extended, much to the delight of Michael and his fellow players.

Throughout his session, Michael experiences several of these trigger events, each one renewing his excitement and encouraging him to continue playing. Even when he's not actively eligible, the possibility of another trigger keeps him engaged and alert to his surroundings.

### Example System Procedural Flow:

1. Casino management programs environmental trigger events into the central control system.
2. During regular gameplay, the central system activates a predetermined trigger event.
3. Environmental systems respond, initiating the programmed light show, sound effect, or other sensory cues.
4. Central system sends a signal to all active DETGs and LDGTs, activating Mystery Jackpot eligibility.
5. Each gaming terminal displays a notification to the active player about their sudden eligibility.
6. System starts a countdown timer for the eligibility period, displayed on each terminal.
7. During the eligibility period, system monitors all eligible games for Mystery Jackpot trigger conditions.
8. If a Mystery Jackpot is triggered, system selects a winner from the pool of eligible players.
9. Winning player is notified, and casino staff are alerted to handle the payout.
10. As eligibility period ends, system resets all terminals to normal operation.
11. Process repeats at random or scheduled intervals throughout operating hours.
12. Data on player engagement during trigger events is collected and analyzed for future optimization.

Noteworthy Aspects and Features: This eligibility criteria introduces a novel way to create a unified and dynamic casino floor experience. By tying jackpot eligibility to environmental cues, it transforms the entire casino into an interactive gaming element. This approach is particularly innovative in how it bridges the gap between traditional slot machine jackpot events and table game play.

The system's ability to integrate with various environmental controls demonstrates a high level of technological sophistication. It may require seamless communication between disparate systems—from individual gaming devices to centralized control systems to lighting and sound equipment.

The unpredictable nature of the trigger events adds a new layer of excitement to casino gaming. It encourages players to remain engaged not just with their individual games, but with the broader casino environment. This may lead to longer play sessions and a more immersive overall experience.

From a marketing perspective, this system offers unparalleled flexibility. Casinos may align trigger events with specific promotions, time periods, or even in response to real-time floor conditions. For example, triggers may be used to energize a quiet gaming floor during off-peak hours.

Lastly, this approach provides casinos with rich data on how environmental factors influence gaming behavior. By analyzing player reactions and engagement levels during and after trigger events, casinos may refine their floor management strategies and optimize the gaming environment for maximum player satisfaction and revenue generation.

### Eligibility Criteria 25—Multiplayer Session Involvement

Description and Implementation: This eligibility criteria focuses on fostering a sense of community and social interaction among players by rewarding participation in multiplayer gaming sessions. Players involved in a multiplayer session with a minimum number of active participants (e.g., five or more) qualify for Mystery Jackpot eligibility. This approach is particularly well-suited for DETGs that offer multiplayer capabilities, such as shared roulette wheels or multiplayer poker tables.

Implementation may require DETGs capable of hosting multiplayer sessions and a centralized system that may track the number of active participants in real-time. When a multiplayer session reaches the required number of players, the system automatically activates Mystery Jackpot eligibility for all participants. This eligibility remains active as long as the minimum player count is maintained, encouraging sustained group play.

### Benefits to Players:

Enhances the social aspect of casino gaming
Provides additional excitement and reward potential for group play
Encourages interaction and friendly competition among players

### Benefits to Casinos:

Increases utilization of multiplayer DETGs
Fosters a more vibrant and social casino atmosphere
Potentially increases player retention through social engagement

Example Walk-through Scenario: Emma visits Wynn Palace Macau and notices a promotion for Mystery Jackpot eligibility on multiplayer DETG sessions. Intrigued, she approaches a multiplayer roulette table with digital betting terminals for each player. The screen displays: “⅗ players active. Join now for a chance at Mystery Jackpot eligibility !”

Emma decides to join, taking one of the open spots. As she begins to play, she chats with the other participants, enjoying the social atmosphere. Soon, a fifth player joins, and all the terminals light up with a notification: “Multiplayer session complete! All players are now eligible for the Mystery Jackpot. Good luck!”

Throughout their session, Emma and her fellow players enjoy the shared experience of the game, cheering each other's wins and commiserating over losses. The added thrill of potential Mystery Jackpot wins keeps the energy high. Players come and go, but the session maintains at least five participants, keeping the eligibility active.

During a particularly exciting round, the Mystery Jackpot is triggered. The system randomly selects one of the eligible players—in this case, Emma—as the winner. The entire group celebrates her win, creating a memorable and exciting moment for all involved.

As the session continues, Emma notices that when the player count occasionally drops below five, the Mystery Jackpot eligibility is temporarily suspended. This encourages the remaining players to invite others to join, maintaining the social dynamics and eligibility status.

By the end of her gaming session, Emma has not only enjoyed the thrill of the game and her jackpot win but has also made new acquaintances. The social experience, combined with the shared excitement of jackpot eligibility, makes her visit to Wynn Palace Macau particularly memorable and enjoyable.

### Example System Procedural Flow:

1. Player approaches a multiplayer DETG and logs in using their player card.
2. System registers the player as active in the multiplayer session.
3. Central system continuously monitors the number of active players in the session.
4. When the player count reaches the predetermined threshold (e.g., 5 players), system activates Mystery Jackpot eligibility for all participants.
5. Each DETG terminal displays a notification informing players of their eligibility status.
6. System continuously checks for maintenance of the minimum player count.
7. If player count drops below the threshold, system suspends eligibility and notifies remaining players.
8. During eligible periods, system monitors for Mystery Jackpot trigger events.
9. When a Mystery Jackpot is triggered, system randomly selects a winner from eligible players.
10. System notifies the winning player and alerts casino staff for payout processing.
11. Eligibility continues for the session as long as the minimum player count is maintained.
12. System collects data on session duration, player engagement, and jackpot frequency for analysis.

Noteworthy Aspects and Features: This eligibility criteria introduces a novel approach to encouraging social interaction in the typically individual-focused world of electronic gaming. By tying Mystery Jackpot eligibility to group participation, it creates a unique blend of individual play and team-like dynamics rarely seen in casino environments.

The system's ability to track and respond to real-time changes in player participation demonstrates sophisticated integration between individual DETGs and the central control system. This real-time responsiveness adds an element of dynamism to the gaming experience, as players actively work together to maintain eligibility.

From a psychological perspective, this approach leverages the power of social proof and group dynamics to enhance player engagement. The shared experience of maintaining eligibility and the collective excitement of potential jackpot wins may significantly increase player satisfaction and time on device.

This criteria also offers a solution to the common casino challenge of balancing electronic gaming convenience with the social atmosphere of traditional table games. By incentivizing group play on DETGs, casinos may create vibrant, community-focused areas within their electronic gaming floors.

The flexibility of this system allows for easy adjustment of player count thresholds and eligibility rules. Casinos may fine-tune these parameters based on time of day, type of game, or specific promotional events, ensuring optimal engagement and floor management.

Lastly, this approach provides valuable data on group play dynamics and social interactions in a casino setting. Analyzing this data may offer insights into player behavior, game preferences, and the impact of social factors on gaming decisions, allowing for more targeted game development and marketing strategies.

### Eligibility Criteria 26—Player Tracking System Engagement

Description and Implementation: This eligibility criteria rewards players who actively engage with the casino's player tracking system during their gaming sessions. Players who use a casino-issued player card to track their performance or accumulate points during play become eligible for Mystery Jackpot awards. This approach encourages players to consistently use their player cards, providing the casino with valuable data while offering players additional rewards for their loyalty.

Implementation involves integrating the DETG and LDGT systems with the casino's existing player tracking infrastructure. When a player inserts their card into a DETG or presents it at an LDGT, the system automatically flags them as eligible for Mystery Jackpot participation. The eligibility remains active as long as the player card is in use and the player is actively gaming.

### Benefits to Players:

Provides additional value for using player cards beyond traditional loyalty points
Offers a chance at significant jackpots without additional wagers
Enhances the overall gaming experience by adding an extra layer of potential rewards

### Benefits to Casinos:

Increases usage of player tracking systems, providing more comprehensive player data
Enhances customer loyalty program effectiveness
Facilitates more personalized marketing and customer service initiatives

Example Walk-through Scenario: David visits the Sands Macao for an evening of gaming. As he approaches a DETG, he notices signage promoting Mystery Jackpot eligibility for players using their casino loyalty cards. Intrigued, David retrieves his Sands Rewards Club card and inserts it into the DETG before beginning his session.

The screen displays a welcome message: “Welcome, David! Your Sands Rewards Club card has activated your Mystery Jackpot eligibility. Good luck!” As David plays, he notices a small jackpot eligibility indicator on the screen, reminding him of this added benefit.

Throughout his session, David sees his loyalty points accumulating in real-time. He also receives personalized offers and notifications based on his playing history. The combination of point accrual, Mystery Jackpot eligibility, and tailored promotions enhances David's gaming experience, making him feel valued as a customer.

After a couple of hours of play, the Mystery Jackpot is triggered. Because David has been consistently using his player card, he is included in the pool of eligible players. To his delight, he is selected as the winner. The screen erupts with a celebratory animation, and a casino host quickly approaches to congratulate him and assist with the payout process.

Even after his big win, David continues to use his player card for the remainder of his visit. He appreciates how the player tracking system not only provided him with an unexpected jackpot win but also customized his entire casino experience.

### Example System Procedural Flow:

1. Player inserts casino loyalty card into a DETG or presents it at an LDGT.
2. System reads the card and retrieves player data from the central database.
3. DETG/LDGT activates Mystery Jackpot eligibility for the player and displays confirmation.
4. System begins tracking player's gaming activity, updating loyalty points in real-time.
5. Throughout the session, system continuously verifies active card use and gameplay.
6. If card is removed or play is inactive for a set period, system suspends Mystery Jackpot eligibility.
7. During eligible periods, system monitors for Mystery Jackpot trigger events.
8. When triggered, system confirms player's continued eligibility before awarding jackpot.
9. System notifies player and casino staff of jackpot win through DETG/LDGT interface.
10. Player's account is updated with jackpot winnings and any accrued loyalty points.
11. System logs detailed play data, including duration, game preferences, and wagering patterns.
12. Analytics team uses collected data to refine personalized offerings and jackpot parameters.

Noteworthy Aspects and Features: This eligibility criteria creates a powerful incentive for players to consistently engage with the casino's player tracking system. By tying Mystery Jackpot eligibility directly to player card usage, it transforms what may be seen as a mundane tracking tool into an exciting gameplay element.

The seamless integration between the player tracking system, DETGs/LDGTs, and the Mystery Jackpot mechanism demonstrates a high level of technological sophistication. This integration allows for real-time eligibility updates and personalized gaming experiences, setting a new standard for player engagement in the casino industry.

From a data collection perspective, this approach is particularly valuable. By incentivizing consistent player card usage, casinos may gather more comprehensive and accurate data on player behavior, preferences, and patterns. This wealth of information may drive more effective marketing strategies, game development, and customer service initiatives.

The system's ability to provide instant feedback and rewards (through both loyalty points and jackpot eligibility) taps into the psychology of immediate gratification, potentially increasing player satisfaction and retention. The visible accrual of points alongside the possibility of a significant jackpot win creates a multi-layered reward system that caters to different player motivations.

Moreover, this criteria allows for highly targeted and personalized gaming experiences. As the system tracks player behavior, it may adjust not only Mystery Jackpot parameters but also game recommendations, bonus offers, and other personalized features in real-time.

Lastly, by encouraging player card usage across all games and sessions, this approach helps create a more unified and comprehensive view of each player's casino journey. This holistic perspective enables casinos to better understand and cater to their customers' needs and preferences, potentially leading to increased loyalty and lifetime value.

### Eligibility Criteria 27˜Casino Property Stays

Description and Implementation: This eligibility criteria rewards players who are staying at the casino's associated hotels during their gameplay, creating a seamless integration between the hospitality and gaming aspects of the casino resort experience. Players who are registered guests at the casino's hotel become eligible for Mystery Jackpot awards when playing at DETGs or LDGTs within the property. This approach encourages players to both stay and play at the casino, maximizing their engagement with the property's full range of offerings.

Implementation may require integration between the casino's hotel management system, player tracking system, and the DETG/LDGT network. When a player checks into the hotel, their account is flagged in the central database. This flag is then recognized by the gaming systems when the player uses their room notable or player card at any gaming terminal, automatically activating their Mystery Jackpot eligibility.

### Benefits to Players:

Adds extra value to their hotel stay through enhanced gaming opportunities
Provides a more integrated and rewarding resort experience
Offers potential for significant wins without additional gaming costs

### Benefits to Casinos:

Encourages longer stays and increased property engagement
Drives cross-promotion between hotel and casino offerings
Enhances the overall value proposition of the integrated resort model

Example Walk-through Scenario: Lisa checks into the luxurious hotel at Galaxy Macau for a weekend getaway. During the check-in process, the concierge informs her about the Mystery Jackpot eligibility for hotel guests, explaining that she may use her room notable at any DETG or LDGT to activate this special feature.

Excited by this perk, Lisa decides to visit the casino floor after settling into her room. She approaches a DETG and inserts her room notable. The screen lights up with a personalized welcome: “Welcome, Lisa! As our valued hotel guest, you are eligible for Mystery Jackpot awards throughout your stay. Enjoy your game!”

As Lisa plays, she notices that her gameplay not only accrues standard loyalty points but also contributes to various resort-wide promotions. The DETG occasionally displays notifications about hotel amenities, restaurant offers, and upcoming shows, creating a fully integrated resort experience.

During her session, the Mystery Jackpot is triggered. Because of her active hotel guest status, Lisa is included in the pool of eligible players and is thrilled to be selected as the winner. A casino host quickly arrives to congratulate her and arrange for the winnings to be credited to her room account or paid out as she prefers.

Throughout her stay, Lisa continues to enjoy this special eligibility status, seamlessly moving between her hotel room, the casino floor, and other resort amenities. The integrated experience and the constant possibility of a Mystery Jackpot win significantly enhance her overall satisfaction with her Galaxy Macau visit.

### Example System Procedural Flow:

1. Guest checks into the casino hotel, and their information is entered into the hotel management system.
2. System automatically flags the guest's account in the central casino database as a current hotel guest.
3. Guest visits the casino floor and inserts their room notable or associated player card into a DETG/LDGT.
4. Gaming system recognizes the hotel guest status and activates Mystery Jackpot eligibility.
5. DETG/LDGT displays confirmation of eligibility and any personalized welcome messages.
6. System tracks guest's gaming activity, integrating it with their overall resort experience data.
7. Throughout the stay, system continuously verifies guest's active hotel status.
8. During eligible periods, system monitors for Mystery Jackpot trigger events.
9. If Mystery Jackpot is triggered, system confirms player's continued eligibility before awarding.
10. System notifies player and casino staff of jackpot win through DETG/LDGT interface.
11. Winnings are processed according to guest preference (room credit, cash, etc.).
12. System logs comprehensive data on guest behavior across gaming and non-gaming activities.

Noteworthy Aspects and Features: This eligibility criteria represents a significant step towards creating a truly integrated resort experience. By linking hotel stays directly to enhanced gaming opportunities, it bridges the gap between different aspects of the guest's visit, potentially increasing overall satisfaction and property engagement.

The seamless integration between hotel management systems, casino player tracking, and gaming systems demonstrates a high level of technological sophistication. This integration allows for real-time eligibility updates and personalized experiences across all touch points of the guest's stay.

From a marketing perspective, this approach opens up numerous opportunities for cross-promotion and upselling. The ability to present targeted offers for non-gaming amenities during gameplay, and vice versa, may significantly increase overall guest spend and engagement with the property.

The system's capacity to track guest behavior across multiple resort venues provides invaluable data for understanding guest preferences and patterns. This comprehensive view enables more effective personalization of offers, services, and experiences, potentially leading to increased guest loyalty and repeat visits.

Moreover, by extending Mystery Jackpot eligibility throughout the entire stay, this criteria encourages guests to engage more frequently with the casino, potentially increasing gaming revenue without requiring additional marketing efforts.

Lastly, this approach aligns well with the integrated resort model popular in destinations like Macau. It enhances the value proposition of staying on-property, which may be a notable differentiator in competitive markets. The promise of exclusive gaming opportunities may be a powerful motivator for guests to choose one resort over another, potentially increasing both hotel occupancy and casino foot traffic.

### Eligibility Criteria 28—Special Promotions Opt-In

Description and Implementation: This eligibility criteria focuses on players who explicitly opt into promotions that advertise jackpot opportunities, typically via an in-game prompt on the Electronic Table Game Terminal (ETGT). The system presents players with promotional offers directly on their ETGT screen, allowing them to actively choose to participate in special jackpot events or promotions. This opt-in process may involve players acknowledging terms and conditions, selecting specific promotional periods, or choosing from a menu of jackpot-related offers. The ETGT interface integrates seamlessly with the casino's promotional management system, ensuring real-time updates and personalized offers based on player history and preferences. Implementation involves developing a user-friendly interface for promotional opt-ins, creating a backend system for managing and tracking opt-ins, and establishing clear communication channels between the ETGTs and the central casino management system.

Benefits to Players: Players gain more control over their gaming experience by choosing which promotions to participate in. This empowers them to tailor their play to their preferences and risk tolerance. The opt-in process ensures players are fully aware of the promotions they're participating in, potentially increasing their engagement and excitement. Players may also benefit from more targeted and relevant promotions, as the system may use their opt-in history to refine future offers.

Benefits to Casinos: Casinos benefit from increased player engagement and a more targeted approach to promotions. The opt-in system allows casinos to gather valuable data on player preferences and promotional effectiveness. This data may be used to refine marketing strategies and create more appealing promotions. The explicit opt-in also provides a clear audit trail for regulatory compliance. Additionally, by offering promotions that players actively choose to participate in, casinos may potentially increase player loyalty and satisfaction.

Example Walk-through Scenario: Sarah, a regular at the casino, sits down at an ETGT to play baccarat. As she inserts her player card, the screen displays a welcome message along with a notification about a new promotion: “Opt-in now for a chance to win our Mystery Jackpot! All opted-in players are eligible for surprise jackpot awards during the next hour.” Intrigued, Sarah taps the “Learn More” button, which brings up details about the promotion, including the potential jackpot amounts and the odds of winning. After reviewing the information, Sarah decides to participate and taps the “Opt-In” button. The screen confirms her participation and reminds her that she's now eligible for the Mystery Jackpot for the next hour.

As Sarah plays, she notices a small icon in the corner of her screen indicating her active participation in the promotion. Thirty minutes into her session, the game pauses briefly, and an animation appears, announcing that she's won a Mystery Jackpot of $500. The screen provides instructions on how to collect her winnings and asks if she'd like to opt-in for the next promotional period. Sarah, excited by her win, chooses to continue participating. The game resumes, with Sarah now more engaged and excited about the possibility of winning again.

Throughout her session, Sarah receives periodic reminders about her opt-in status and is presented with opportunities to participate in other promotions. She finds this feature enhances her gaming experience, making her feel more in control and adding an extra layer of excitement to her play.

### Example System Procedural Flow:

1. Player inserts player card into ETGT or logs in via mobile device.
2. ETGT communicates with Player Tracking System (PTS) to retrieve player data.
3. Promotional Management System (PMS) checks player eligibility for current promotions.
4. PMS sends eligible promotions to ETGT for display.
5. ETGT presents promotion opt-in prompt to player on screen.
6. Player interacts with prompt, reviewing details and choosing to opt-in.
7. ETGT sends opt-in confirmation to PMS.
8. PMS updates player record with opt-in status and notifies other relevant systems.
9. ETGT receives confirmation and updates UI to reflect opt-in status.
10. During gameplay, ETGT continuously communicates with PMS to verify opt-in status.
11. Random Number Generator (RNG) system periodically triggers Mystery Jackpot events.
12. When triggered, PMS checks all active, opted-in players for eligibility.
13. If player wins, PMS notifies ETGT and Jackpot Management System (JMS).
14. ETGT interrupts gameplay to display win animation and information.
15. JMS processes jackpot payout and updates financial systems.
16. ETGT prompts player for continued opt-in or new promotional offers.
17. Player response is sent back to PMS for processing and record updating.
18. ETGT resumes normal gameplay, maintaining opt-in status indicator.
19. At opt-in period end, PMS notifies ETGT to update status and offer renewal.
20. Process repeats for new promotional periods or as player initiates new opt-ins.

Noteworthy Aspects and Features: This eligibility criteria introduces a novel approach to player engagement by putting the power of choice directly in the hands of the player. The real-time, interactive nature of the opt-in process on the ETGT is a significant advancement over traditional promotional methods. The system's ability to immediately act on a player's opt-in decision, integrating it seamlessly into the gameplay, represents a technological leap in casino management systems. The continuous communication between the ETGT and various backend systems ensures a dynamic and responsive player experience. The combination of personalized promotions, clear opt-in processes, and immediate feedback creates a transparent and engaging environment that may significantly enhance player trust and loyalty. Moreover, the data collected through this system provides casinos with unprecedented insights into player behavior and preferences, allowing for more effective and targeted marketing strategies.

Eligibility Criteria 29—Purchase of in-Game Items

Description and Implementation: This eligibility criteria is based on players purchasing in-game items or upgrades within the Electronic Table Game Terminal (ETGT) environment. While traditional table games don't typically feature purchasable items, this innovative approach introduces a new dimension to live dealer games. Players may buy virtual items such as “lucky charms,” custom card designs, or special betting options that enhance their gaming experience without affecting the specific game mechanics or odds. These purchases not only qualify players for Mystery Jackpot participation but also add a layer of personalization and engagement to the game.

Implementation involves integrating a virtual store within the ETGT interface, connected to the casino's payment processing system. The store offers a variety of themed items, optionally tied to current casino promotions or events. Each purchase is logged in real-time, immediately qualifying the player for Mystery Jackpot eligibility. The system tracks purchase history, allowing for targeted offers and progressive unlocks of more valuable items, which in turn may offer enhanced jackpot chances.

Benefits to Players: Players enjoy a more personalized and immersive gaming experience through customizable elements. The ability to purchase unique items adds a collectible aspect to their play, increasing engagement. These purchases provide tangible benefits in the form of Mystery Jackpot eligibility, giving players an additional chance to win beyond the base game. The variety of purchasable items caters to different player preferences, allowing them to enhance their gaming experience in ways that appeal to them personally.

Benefits to Casinos: Casinos gain an additional revenue stream through in-game purchases, diversifying their income beyond traditional wagers. This system increases player engagement and time spent at ETGTs, potentially leading to higher overall gaming revenue. The data collected from purchase patterns provides valuable insights into player preferences, enabling more targeted marketing and game development. The Mystery Jackpot tie-in incentivizes purchases, creating a symbiotic relationship between the virtual store and jackpot participation.

Example Walk-through Scenario: John, a regular casino patron, sits down at an ETGT to play blackjack. As he logs in with his player card, he notices a new icon on the screen labeled “Lucky Shop.” Intrigued, John taps the icon, revealing a virtual store with various purchasable items. He sees options for custom card backs, digital lucky charms, and special betting options like “Lucky Streak Insurer.”

Excited by one aspect of novelty, John decides to purchase a set of golden card backs for $5. The interface smoothly processes his purchase, deducting the amount from his player account. A notification pops up: “Congratulations! Your purchase has qualified you for today's Mystery Jackpot!” John notices anew jackpot eligibility indicator appear on his screen.

As John plays, he enjoys seeing his custom golden cards dealt on the virtual table. After a few hands, he decides to try the “Lucky Streak Insurer” for $10. This special option allows him to protect a winning streak, adding an extra element of strategy to his play.

Halfway through his session, the game suddenly pauses. An animation takes over the screen, announcing that John has won a Mystery Jackpot of $1,000! The win is directly attributed to his earlier purchases, which maintained his eligibility throughout his play.

Excited by his win, John explores the Lucky Shop further. He notices that some items are labeled as “Jackpot Boosters,” offering increased chances or higher tiers of Mystery Jackpots. John purchases a “Silver Horseshoe” charm for $20, which the game informs him will increase his Mystery Jackpot odds for the next hour.

As John continues to play, he receives periodic notifications about new items in the shop, some tied to his playing style or current casino promotions. He finds himself more engaged with the game, enjoying the personalization aspects and the added thrill of potential jackpot wins tied to his purchases.

### Example System Procedural Flow:

1. Player logs into ETGT using player card or mobile app.
2. ETGT communicates with Player Tracking System (PTS) to retrieve player data and account balance.
3. ETGT interface loads, displaying the “Lucky Shop” icon.
4. Player taps the “Lucky Shop” icon, triggering a request to the Virtual Item Management System (VIMS).
5. VIMS sends current inventory, prices, and player-specific offers to ETGT.
6. ETGT displays the virtual store interface with available items.
7. Player selects an item to purchase.
8. ETGT sends purchase request to VIMS.
9. VIMS verifies player account balance with PTS.
10. If sufficient funds, PTS deducts purchase amount from player account.
11. VIMS records the purchase and updates player's virtual inventory.
12. VIMS notifies Jackpot Eligibility System (JES) of the purchase.
13. JES updates player's Mystery Jackpot eligibility status.
14. ETGT receives confirmation and updates UI, showing purchased item and jackpot eligibility.
15. During gameplay, ETGT continuously communicates with JES to maintain eligibility status.
16. Random Number Generator (RNG) system periodically triggers Mystery Jackpot events.
17. When triggered, JES checks all eligible players based on recent purchases.
18. If player wins, JES notifies ETGT and Jackpot Management System (JMS).
19. ETGT interrupts gameplay to display win animation and information.
20. JMS processes jackpot payout and updates financial systems.
21. VIMS analyzes purchase data and player behavior.
22. VIMS generates personalized offers or unlocks new items based on analysis.
23. ETGT periodically checks VIMS for new offers or items to display to the player.
24. If player makes additional purchases, steps 7-15 are repeated.
25. At end of gaming session, ETGT sends final play and purchase data to PTS and VIMS.
26. PTS and VIMS update player profile with session data for future personalization.

Noteworthy Aspects and Features: This eligibility criteria introduces a novel microtransaction model to traditional table games, bridging the gap between conventional casino gaming and modem video game monetization strategies. The integration of a virtual store within the ETGT environment is a significant innovation, offering a new dimension of personalization in live dealer games. The direct link between purchases and Mystery Jackpot eligibility creates a unique incentive structure, encouraging player engagement with the virtual items beyond mere aesthetics.

The system's ability to offer dynamic, personalized items based on player behavior and casino promotions showcases advanced data analytics and real-time marketing capabilities. The “Jackpot Booster” concept introduces a strategic element to jackpot participation, allowing players to influence their winning odds through purchases. This feature walks a fine line between enhancing player experience and maintaining game integrity, requiring careful balance and regulatory consideration.

The seamless integration of purchase tracking, jackpot eligibility, and personalized offerings demonstrates a sophisticated, interconnected casino management system that enhances both player experience and casino operations.

### Eligibility Criteria 30—Concurrent Play at Multiple Terminals

Description and Implementation: This eligibility criteria rewards players who actively engage in gameplay at two or more Electronic Table Game Terminals (ETGTs) simultaneously. The system recognizes and encourages multi-table play, a skill often associated with advanced players. Implementation may require a networked system that may track player activity across multiple terminals in real-time. Each ETGT is equipped with player identification technology, such as card readers or biometric scanners, allowing the system to associate active games with specific players.

The casino management system continuously monitors active sessions, identifying instances where a single player is engaged in games on multiple terminals. To qualify, players must maintain active gameplay on each terminal, with specific thresholds for bet frequency and amount to prevent minimal play for eligibility. The system may be configured to may require a minimum number of concurrent active terminals (e.g., two or three) and a minimum duration of simultaneous play (e.g., 15 minutes) for Mystery Jackpot eligibility.

Benefits to Players: Players who enjoy fast-paced, multi-table gameplay are rewarded for their skills and engagement level. This criteria offers an additional layer of excitement and potential rewards beyond the standard game outcomes. It caters to experienced players looking for more challenging and stimulating gaming experiences. The opportunity to qualify for Mystery Jackpots through multi-table play may make longer gaming sessions more engaging and potentially more profitable.

Benefits to Casinos: This criteria encourages higher overall play volume and increased time on device, potentially leading to higher revenue per player. It attracts and retains skilled players who often have larger bankrolls and are willing to place higher bets. The system showcases the casino's technological capabilities, positioning it as an innovative gaming destination. It also provides valuable data on player behavior and skills, which may be used for targeted marketing and VIP program enhancements.

Example Walk-through Scenario: Michael, an experienced gambler, enters the casino's electronic table game area. He approaches a bank of ETGTs offering various games including blackjack, baccarat, and roulette. Michael inserts his player card into two adjacent terminals—one for blackjack and another for baccarat.

As he begins playing both games simultaneously, a notification appears on both screens: “Multi-Table Play Detected! Maintain active play on both terminals for 15 minutes to qualify for the Mystery Jackpot!” Excited by this opportunity, Michael ensures he's placing regular bets on both games.

While managing his blackjack hands, Michael quickly switches focus to place bets on the baccarat table. The system tracks his consistent activity on both terminals. After 10 minutes, another message appears: “5 more minutes of Multi-Table Play to qualify for Mystery Jackpot! Consider adding a third table for increased jackpot odds!”

Intrigued, Michael logs into a nearby roulette ETGT using his mobile device, now actively playing three games. The system immediately recognizes this escalation, updating his status across all three terminals.

As the 15-minute mark approaches, the screens display a countdown. Upon reaching 15 minutes of concurrent play, celebratory animations appear on all three screens, confirming Michael's eligibility for the Mystery Jackpot.

For the next hour, Michael continues his multi-table play, skillfully managing his bets across all three games. Suddenly, the roulette screen freezes, displaying a massive “MYSTERY JACKPOT WIN!” animation. Michael has won a $5,000 jackpot, awarded specifically for his multi-table play prowess.

Casino staff approach to congratulate Michael, and other players in the area take notice of his win. Energized by his success, Michael continues his multi-table play, now aware that each minute of concurrent play may lead to another jackpot opportunity.

### Example System Procedural Flow:

1. Player inserts player card or logs in via mobile device at multiple ETGTs.
2. Each ETGT communicates with the Player Tracking System (PTS) to authenticate the player.
3. PTS notifies the Multi-Table Play Monitoring System (MTPMS) of the player's activity.
4. MTPMS initiates tracking of the player's concurrent play across multiple terminals.
5. MTPMS sets activity thresholds for each game type (e.g., minimum bets per minute).
6. ETGTs send real-time gameplay data to MTPMS, including bet amounts and frequency.
7. MTPMS continuously analyzes the data to ensure the player meets activity thresholds on all terminals.
8. Upon detecting qualified multi-table play, MTPMS notifies the Jackpot Eligibility System (JES).
9. JES initiates a 15-minute countdown for Mystery Jackpot eligibility.
10. ETGTs display notifications to the player about their multi-table play status and countdown.
11. If player adds additional terminals, MTPMS updates the player's status in real-time.
12. JES communicates with the Random Number Generator (RNG) system for jackpot triggers.
13. Upon reaching 15 minutes of qualified play, JES confirms the player's eligibility for Mystery Jackpot.
14. ETGTs display confirmation of eligibility to the player.
15. MTPMS continues monitoring play across all active terminals.
16. If play on any terminal falls below the threshold, MTPMS notifies JES to suspend eligibility.
17. RNG periodically triggers Mystery Jackpot events.
18. When triggered, JES checks all eligible multi-table players.
19. If a player wins, JES notifies all of the player's active ETGTs and the Jackpot Management System (JMS).
20. ETGTs interrupt gameplay to display win animations across all of the player's terminals.
21. JMS processes the jackpot payout and updates financial systems.
22. PTS updates the player's profile with multi-table play statistics and jackpot win data.
23. Casino Management System (CMS) is notified of the win for floor management and security purposes.
24. MTPMS resets the player's eligibility timer, beginning a new qualification period.
25. ETGTs resume normal gameplay, maintaining eligibility status indicators.
26. MTPMS continues to monitor for any changes in the player's multi-table play status.
27. At the end of the gaming session, MTPMS sends a complete multi-table play report to PTS and CMS for analysis.

Noteworthy Aspects and Features: This eligibility criteria introduces a sophisticated multi-table play tracking system that bridges individual ETGTs into a cohesive, player-centric gaming experience. The real-time monitoring and analysis of gameplay across multiple terminals showcase advanced networking and data processing capabilities within the casino environment.

The system's ability to dynamically adjust eligibility based on the number of active terminals and gameplay intensity demonstrates a flexible and responsive approach to player engagement. This feature not only rewards skillful players but also encourages a more immersive and interactive casino experience.

The integration of mobile device login alongside traditional player cards illustrates a forward-thinking approach to player accessibility and convenience. The synchronized notifications and win animations across multiple terminals create a unified and exciting visual experience for the player and surrounding guests, potentially driving interest in multi-table play.

This criteria effectively gamifies the act of playing multiple casino games simultaneously, adding a meta-layer of achievement and reward to traditional table game play.

### Eligibility Criteria 31—Shared Network Participation

Description and Implementation: This eligibility criteria enables players participating in networked games across multiple casinos using the same DETG system to qualify for a cross-casino jackpot. The system links players from different physical locations or online platforms, creating a larger player pool and potentially bigger jackpots. Implementation may require a robust, secure network connecting all participating casinos and a centralized system for managing the shared jackpot. Each ETGT is connected to this network, allowing real-time data exchange and synchronized jackpot updates across all locations.

The system tracks player activity across all connected casinos, with each qualifying bet contributing to the shared jackpot pool. Players may see the total number of participants across all locations and watch the jackpot grow in real-time. To maintain fairness, the system adjusts entry requirements or jackpot contributions based on local regulations or casino-specific rules.

Benefits to Players: Players enjoy access to larger jackpots due to the increased number of contributors across multiple locations. The system offers a sense of community and competition on a broader scale, enhancing the gaming experience. Players may participate in cross-casino events or tournaments, adding variety to their play. The ability to qualify for jackpots while playing at different locations provides flexibility and continued engagement even when traveling.

Benefits to Casinos: Casinos may offer more attractive jackpots without bearing the entire financial burden themselves. The shared system may drive cross-promotion between participating locations, potentially increasing overall player traffic. It allows smaller casinos to offer jackpot experiences comparable to larger establishments. The network creates opportunities for collaborative marketing efforts and data sharing, leading to improved player insights and marketing strategies.

Example Walk-through Scenario: Lisa sits down at an ETGT in Casino A in Las Vegas. As she logs in, she notices a special icon indicating “Multi-Casino Jackpot Network Active.” The screen displays the current jackpot amount of $500,000 and shows that 1,500 players across 10 casinos are currently participating.

As Lisa plays, she sees the jackpot amount increasing rapidly, with notifications popping up: “Player from Casino B in Atlantic City just contributed!” or “50 new players joined from Casino C in Macau!” This real-time information adds excitement to her gameplay.

During her session, Lisa receives an alert about a cross-casino tournament starting in 30 minutes. She opts in, knowing she'll be competing against players from all participating locations. As the tournament begins, a leaderboard appears, showing top players from various casinos.

Suddenly, the game pauses, and a dramatic animation takes over the screen. “Congratulations! Player at Casino D in Singapore has won the Multi-Casino Jackpot!” The screen shows the winning hand and the player's username. While Lisa didn't win this time, she's excited by the scale of the game she's participating in.

As play resumes, Lisa notices the jackpot has reset but is climbing quickly due to the large player base. She continues playing, knowing that every hand gives her a chance at the next big multi-casino win.

### Example System Procedural Flow:

1. Player logs into ETGT at Casino A.
2. ETGT connects to local Casino Management System (CMS) and Multi-Casino Network (MCN).
3. MCN verifies casino and ETGT credentials.
4. MCN sends current jackpot amount and participation data to ETGT.
5. ETGT displays network jackpot information to player.
6. Player places a bet, ETGT sends bet data to local CMS and MCN.
7. MCN updates central jackpot pool and broadcasts update to all connected ETGTs.
8. MCN's Random Number Generator (RNG) continuously runs for jackpot triggers.
9. Player continues gameplay, with each bet updating local and network systems.
10. RNG triggers a jackpot win at Casino D.
11. MCN verifies win conditions and player eligibility.
12. MCN freezes jackpot contributions and notifies all connected systems of the win.
13. All ETGTs display win animation and winner information.
14. MCN coordinates with Casino D's CMS for winner verification and payout.
15. Once verified, MCN resets jackpot to starting amount.
16. MCN broadcasts new jackpot amount to all ETGTs.
17. System resumes normal operation, accumulating new contributions.

Noteworthy Aspects and Features: This eligibility criteria introduces a novel approach to casino networking, creating a unified gaming experience across multiple properties. The real-time synchronization of jackpot data and player activity across geographically dispersed locations represents a significant technological achievement. The system's ability to manage different regulatory requirements across jurisdictions while maintaining a seamless player experience is particularly innovative. The cross-casino tournaments and events enabled by this network create new forms of player engagement that transcend traditional casino boundaries. This shared network also paves the way for more sophisticated player tracking and reward systems that may operate across multiple properties or even multiple casino operators.

### Eligibility Criteria 32—Engagement in Specific Dealer Interactions

Description and Implementation: This eligibility criteria rewards players who engage in specific interactions with live dealers, such as tipping or placing bets for the dealer. The system aims to encourage positive player-dealer relationships and enhance the overall gaming atmosphere. Implementation involves equipping each ETGT with special interface options for dealer interactions and training dealers to use these features effectively.

The ETGT interface includes dedicated buttons or gestures for tipping the dealer or placing dealer bets. Each interaction is logged and contributes to the player's eligibility for Mystery Jackpots. The system may require a minimum number or frequency of interactions within a given time period to maintain eligibility.

Benefits to Players: Players enjoy a more interactive and social gaming experience, fostering a connection with the dealer. The system rewards courteous behavior, potentially leading to a more positive atmosphere at the table. Players have additional ways to potentially influence their jackpot eligibility beyond standard gameplay.

Benefits to Casinos: This criteria encourages tipping, potentially increasing dealer job satisfaction and retention. It promotes a friendlier gaming environment, which may lead to longer play sessions and repeat visits. The system provides data on player-dealer interactions, offering insights into customer service quality and player preferences.

Example Walk-through Scenario: Tom sits down at an ETGT for a game of blackjack. The live dealer, Sarah, welcomes him through the video feed. As Tom places his first bet, he notices a “Tip Dealer” button on the screen. Feeling generous, he taps it and selects a $5 tip. The screen flashes, “Thanks for tipping! You've earned 1 Jackpot Point!”

As the game progresses, Tom uses the “Bet for Dealer” option, placing a small side bet for Sarah. She thanks him, and Tom's Jackpot Points increase. A notification appears: “5 Jackpot Points earned! You're now eligible for the next Mystery Jackpot draw!”

Throughout his session, Tom continues to interact with Sarah, occasionally tipping or betting for her. Each interaction increases his Jackpot Points and eligibility duration. During a particularly good run, Tom uses the “Celebrate with Dealer” emote, which Sarah reciprocates, adding to the friendly atmosphere.

Suddenly, the game pauses, and a jackpot animation appears. Tom has won a $1000 Mystery Jackpot! The system announces that his win was directly tied to his positive dealer interactions. Both Tom and Sarah celebrate the win, creating a memorable and enjoyable gaming experience.

### Example System Procedural Flow:

1. Player logs into ETGT and game begins with live dealer connection.
2. ETGT displays dealer interaction options (tip, bet for dealer, emotes).
3. Player selects a dealer interaction option.
4. ETGT sends interaction data to Dealer Interaction Tracking System (DITS).
5. DITS logs the interaction and calculates Jackpot Points.
6. DITS communicates with Jackpot Eligibility System (JES) to update player status.
7. ETGT displays updated Jackpot Points and eligibility status to player.
8. Live dealer receives notification of player's interaction on their interface.
9. DITS continually monitors interaction frequency and recency.
10. JES periodically checks player's eligibility based on DITS data.
11. Random Number Generator (RNG) system triggers Mystery Jackpot events.
12. JES cross-references eligible players with RNG triggers.
13. If player wins, JES notifies ETGT and Jackpot Management System (JMS).
14. ETGT displays win animation and notifies live dealer.
15. JMS processes jackpot payout and updates financial systems.
16. DITS resets player's interaction counters post-win.
17. System resumes normal operation, tracking new interactions.

Noteworthy Aspects and Features: This eligibility criteria innovatively gamifies social interactions in a digital environment, bridging the gap between traditional casino etiquette and modem gaming technology. The system's ability to quantify and reward social behaviors adds a unique dimension to the player experience. The real-time tracking and reward of dealer interactions represent a novel approach to enhancing the live dealer gaming experience in a digital format. This feature also addresses the challenge of maintaining the social aspects of casino gaming in an increasingly digital environment, potentially setting a new standard for online and hybrid casino experiences.

### Eligibility Criteria 33—Contribution to Jackpot Pool

Description and Implementation: This eligibility criteria is based on players' direct contributions to the jackpot pool, typically through side bets or a percentage of their main wagers. The system allows players to actively participate in building the jackpot they're trying to win. Implementation involves creating a clear interface for players to make jackpot contributions, either as optional side bets or as an automatic percentage of their main bets.

The ETGT tracks each player's cumulative contributions to the jackpot pool. Players may need to reach certain contribution thresholds to become eligible for different tiers of jackpots. The system may offer real-time displays of individual contributions and their impact on the overall jackpot size.

Benefits to Players: Players have more control over their jackpot eligibility and potential winnings. The system creates a sense of ownership and investment in the jackpot. Players may see a direct correlation between their contributions and the growing jackpot, adding excitement to their gameplay.

Benefits to Casinos: This system ensures a constantly growing jackpot pool, making large payouts more feasible. It encourages higher betting volumes as players are motivated to contribute more to increase their eligibility. The transparent nature of contributions may lead to increased player trust and engagement.

Example Walk-through Scenario: Emma starts playing at an ETGT, noticing a “Jackpot Contribution” meter on her screen. She learns that 2% of each bet automatically goes to the jackpot pool, with an option to increase this percentage. Emma decides to bump her contribution to 5% for the session.

As Emma plays, she watches her personal contribution meter grow. The main jackpot display shows both the total pool and Emma's percentage of contribution. After an hour, a notification appears: “You've contributed $50 to the jackpot! You're now eligible for Tier 2 jackpots!”

Excited by her progress, Emma continues playing. She notices that when she hits a winning streak, her contributions increase faster. The ETGT occasionally offers “Contribution Boost” periods where her percentage is temporarily doubled.

Suddenly, the game announces a jackpot win. While Emma isn't the main winner, she receives a small payout as a “Contribution Bonus” based on her percentage of the total pool. This encourages her to continue playing and contributing, aiming for larger jackpots in the future.

### Example System Procedural Flow:

1. Player logs into ETGT and sets desired jackpot contribution percentage.
2. ETGT communicates contribution settings to Jackpot Contribution System (JCS).
3. Player places bets; ETGT calculates contribution amount for each bet.
4. ETGT sends bet and contribution data to JCS and Casino Management System (CMS).
5. JCS updates player's individual contribution total and overall jackpot pool.
6. JCS communicates with Jackpot Eligibility System (JES) to update player's eligibility status.
7. ETGT displays updated contribution totals and eligibility information to player.
8. JCS periodically checks for contribution milestones (e.g., tier thresholds).
9. When milestone is reached, JCS notifies ETGT and JES.
10. ETGT displays milestone achievement to player.
11. Random Number Generator (RNG) system triggers jackpot events.
12. JES cross-references eligible players and their contribution levels with RNG triggers.
13. If jackpot is won, JCS calculates payouts based on contribution percentages.
14. Jackpot Management System (JMS) processes main jackpot and contribution bonuses.
15. ETGT displays win information and any contribution bonuses to players.
16. JCS resets jackpot pool and maintains player contribution history for the next round.

Noteworthy Aspects and Features: This eligibility criteria introduces a more dynamic and participatory approach to jackpot systems in casino gaming. The direct link between player contributions and jackpot eligibility creates a new layer of strategy in how players approach their gaming sessions. The tiered eligibility based on contribution levels adds depth to the jackpot system, catering to both casual and high-rolling players. The real-time display of personal contributions and their impact on the overall jackpot represents a new level of transparency in casino operations. This system also introduces the concept of “partial” jackpot wins through contribution bonuses, ensuring that consistent contributors are rewarded even if they don't hit the main jackpot.

### Eligibility Criteria 38—New Player Bonus

Description and Implementation: The New Player Bonus eligibility criteria is designed to incentivize new players to engage with Live Dealer Game Tables (LDGTs) and Dealer-controlled Electronic Table Games (DETGs) by offering them the opportunity to participate in Mystery Jackpot awards within their first 24 hours of play at the casino. This criteria is implemented through a sophisticated player tracking and timing system integrated into the casino's network and individual Electronic Table Game Terminals (ETGTs).

When a new player registers at the casino, they are issued a unique player ID and card. This information is logged in the casino's central player database with a timestamp. As the player begins their gaming session at an ETGT, the system continuously monitors their activity. The ETGT communicates with the central server, which checks the player's registration time against the current time. If the player is within the 24-hour window, they are automatically eligible for Mystery Jackpot participation.

The system may also incorporate a visual indicator on the ETGT screen, such as a special icon or timer, showing the player their eligibility status and remaining time. This creates a sense of urgency and excitement, encouraging extended play. Additionally, the casino may offer tiered Mystery Jackpot opportunities within this 24-hour window, with increasing potential rewards as the player's engagement grows.

### Benefits to Players:

1. Immediate access to high-value rewards upon joining the casino
2. Enhanced gaming experience with added excitement from jackpot eligibility
3. Opportunity to win significant prizes early in their casino journey
4. Clear visibility of their special status through on-screen indicators
5. Incentive to explore various games and features within the initial 24-hour period

### Benefits to Casinos:

1. Increased new player acquisition and retention
2. Higher engagement levels from new players in their notable first 24 hours
3. Opportunity to showcase various games and features to new players
4. Potential for viral marketing as new players share their experiences
5. Ability to gather valuable data on new player preferences and behaviors
6. Differentiation from competitors by offering unique new player incentives

Example Walk-through Scenario: John, a first-time visitor to the Golden Dragon Casino in Macau, decides to try his luck at the electronic baccarat tables. Upon entering, he's greeted by a casino host who assists him in registering for a player card. The host explains that as a new player, John is eligible for Mystery Jackpot awards on any DETG for the next 24 hours.

Excited by this prospect, John approaches an available electronic baccarat terminal. He inserts his newly acquired player card, and the screen illuminates with a special “New Player Bonus” animation. A countdown timer appears in the corner, showing 23:58:45 remaining for his Mystery Jackpot eligibility.

As John begins to play, he notices that certain hands trigger a “Mystery Jackpot Opportunity” event. The first time this happens, a brief tutorial explains that these events give him a chance at winning one of several mystery prizes, including a massive progressive jackpot.

Throughout his session, John experiences several near-misses with the Mystery Jackpot, building anticipation. He decides to try different games, moving from baccarat to roulette and then to sic bo, all while remaining eligible for the special new player jackpots.

After a few hours of play, John takes a break for dinner. When he returns to the gaming floor, he sees that he still has 19 hours of eligibility left. This motivates him to continue playing, hoping to hit the Mystery Jackpot before his time runs out.

In the final hour of his eligibility period, the system triggers more frequent Mystery Jackpot Opportunities, creating a thrilling finale to John's new player experience. Although he doesn't win the top prize, he does hit a smaller Mystery Jackpot of 5,000 HKD, leaving him with a positive impression of the casino and eager to return for more chances at the main jackpot.

### Example System Procedural Flow:

1. New Player Registration:
   Casino staff enters player details into the central Player Management System (PMS)
   PMS generates a unique player ID and associates it with a physical player card
   PMS records the registration timestamp and sets a 24-hour eligibility flag
2. Player Initiates Gaming Session:
   Player inserts card into ETGT
   ETGT reads card and sends player ID to the Table Game Management System (TGMS)
   TGMS queries PMS for player status and eligibility
   PMS confirms new player status and calculates remaining eligibility time
3. ETGT Session Initialization:
   TGMS sends eligibility confirmation and remaining time to ETGT
   ETGT displays New Player Bonus interface elements, including countdown timer
   ETGT activates Mystery Jackpot module for the player's session
4. Continuous Eligibility Monitoring:
   TGMS regularly polls PMS for updated eligibility status
   PMS checks current time against registration timestamp
   If within 24-hour window, PMS maintains eligibility flag
5. Mystery Jackpot Opportunity Generation:
   Random Number Generator (RNG) in TGMS periodically triggers jackpot opportunities
   TGMS sends trigger signal to ETGT
   ETGT displays Mystery Jackpot Opportunity animation
6. Player Interaction with Jackpot Opportunity:
   Player interacts with jackpot feature on ETGT
   ETGT sends interaction data to TGMS
   TGMS uses RNG to determine jackpot outcome
7. Jackpot Award Processing:
   If jackpot is won, TGMS notifies Jackpot Management System (JMS)
   JMS verifies win and player eligibility with PMS
   JMS instructs TGMS to credit player account
   TGMS sends win notification to ETGT for display
8. Session End and Eligibility Update:
   Player cashes out or removes card from ETGT
   ETGT sends session end signal to TGMS
   TGMS updates PMS with player's activity data
   PMS recalculates remaining eligibility time
9. Multi-day Tracking:
   PMS continues to monitor 24-hour window across multiple sessions
   When 24 hours elapse, PMS updates player status to standard
   PMS notifies TGMS of status change for future sessions

This procedural flow ensures seamless integration of the New Player Bonus eligibility criteria across multiple casino systems, providing a secure and engaging experience for new players while maintaining the integrity of the Mystery Jackpot feature.

Noteworthy Aspects and Features: The New Player Bonus eligibility criteria introduces several novel and unique features to the casino gaming experience:
1. Time-Based Jackpot Eligibility: Unlike traditional systems where jackpot eligibility is typically based on bet size or game type, this system introduces a time-sensitive element, creating urgency and encouraging immediate engagement.
2. Cross-Game Portability: The eligibility follows the player across different types of DETGs, promoting game exploration and extended play sessions.
3. Dynamic Jackpot Opportunity Frequency: The system may adjust the frequency of Mystery Jackpot Opportunities based on remaining eligibility time, player behavior, and casino occupancy, optimizing engagement and floor management.
4. Integrated Onboarding Experience: By tying jackpot eligibility to the initial registration process, the system creates a seamless transition from sign-up to high-value play, potentially reducing new player anxiety and increasing retention.
5. Data-Driven Player Profiling: The 24-hour intensive engagement period provides the casino with a rich dataset for understanding new player preferences and behaviors, enabling personalized marketing and game recommendations.
6. Scalable Eligibility Framework: This system may be easily adapted for other time-based promotions or tailored for specific player segments, offering a flexible tool for casino marketing strategies.
   Eligibility Criteria 39—Achievement of in-Game Challenges

Description and Implementation: The Achievement of In-Game Challenges eligibility criteria introduces a skill-based component to Mystery Jackpot participation in Live Dealer Game Tables (LDGTs) and Dealer-controlled Electronic Table Games (DETGs). This system rewards players who demonstrate proficiency or luck by completing specific in-game challenges during their gameplay sessions. These challenges are designed to be game-specific and may vary in difficulty, offering a tiered approach to Mystery Jackpot eligibility.

Implementation involves integrating a challenge tracking module into the existing DETG software. This module monitors gameplay in real-time, recognizing predefined patterns or outcomes that constitute a challenge completion. For example, in blackjack, a challenge may be to win three hands in a row with a natural blackjack. In baccarat, it may be correctly predicting a tie bet three times within 20 hands.

The system maintains a database of available challenges, their difficulty levels, and corresponding Mystery Jackpot eligibility tiers. As players engage with the games, their progress towards these challenges is tracked and displayed on their individual Electronic Table Game Terminal (ETGT) screens. Upon completing a challenge, the player receives immediate visual and auditory feedback, and their Mystery Jackpot eligibility is upgraded to the corresponding tier.

This eligibility criteria not only adds an extra layer of excitement to standard gameplay but also encourages players to engage more deeply with the games, potentially improving their skills and understanding of game strategies.

### Benefits to Players:

1. Added dimension of achievement and progression within games
2. Increased engagement and excitement during regular gameplay
3. Opportunity to earn jackpot eligibility through skill and strategy
4. Clear goals and rewards beyond standard game outcomes
5. Sense of accomplishment and recognition for gameplay proficiency

### Benefits to Casinos:

1. Increased player engagement and time on device
2. Promotion of skill development, potentially leading to higher-stakes play
3. Differentiation from competitors through unique, challenge-based rewards
4. Ability to gather detailed data on player skill levels and game preferences
5. Potential to attract skilled players who appreciate recognition of their abilities
6. Flexible system for introducing new challenges and promotions

Example Walk-through Scenario: Lisa, an experienced baccarat player, sits down at a DETG baccarat table at the Venetian Macao. As she inserts her player card, the screen displays a list of active in-game challenges. One challenge catches her eye: “Dragon's Breath—Correctly predict the outcome of five consecutive hands.” The reward for completing this challenge is eligibility for the Diamond Tier Mystery Jackpot, the highest available.

Excited by the prospect, Lisa begins to play. The ETGT screen shows her current challenge progress in a subtle but clear display. As she correctly predicts the first three hands, the anticipation builds. Other players at nearby terminals notice her streak and gather around, adding to the excitement.

On the fourth hand, Lisa hesitates before placing her bet. The dealer, aware of the challenge system, respectfully waits for her decision. Lisa correctly predicts the fourth hand, and the ETGT erupts with celebratory animations and sounds, alerting everyone to her impending achievement.

For the fifth hand, Lisa takes her time, analyzing the previous outcomes and considering her options. She places her bet, and as the cards are revealed, the entire table holds its breath. When Lisa's prediction proves correct, the ETGT screen explodes with congratulatory messages. A special animation plays, showing Lisa's eligibility status upgrading to the Diamond Tier.

From this point forward in her session, Lisa is now eligible for the top-tier Mystery Jackpot. The system periodically reminds her of this status, maintaining her excitement and encouraging continued play. Other players, inspired by Lisa's achievement, begin to focus more intently on their own gameplay, hoping to complete challenges of their own.

### Example System Procedural Flow:

1. Challenge Configuration:
   Casino management defines challenges in the Challenge Management System (CMS)
   CMS distributes challenge data to the Table Game Management System (TGMS)
   TGMS updates all connected DETGs with new challenge information
2. Player Session Initiation:
   Player inserts card into ETGT
   ETGT queries TGMS for player data and available challenges
   TGMS retrieves player history and challenge eligibility from Player Management System (PMS)
   ETGT displays personalized challenge list to player
3. Gameplay Monitoring:
   ETGT continuously tracks player actions and game outcomes
   Data is sent in real-time to TGMS for analysis
   TGMS compares gameplay data against active challenge criteria
4. Challenge Progress Updates:
   TGMS calculates progress towards each active challenge
   Progress updates are sent to ETGT for display
   ETGT updates progress bars or other visual indicators
5. Challenge Completion Detection:
   TGMS detects when a challenge's criteria are met
   TGMS signals ETGT of challenge completion
   ETGT triggers celebration sequence and updates display
6. Eligibility Upgrade Processing:
   TGMS notifies Jackpot Management System (JMS) of player's new eligibility tier
   JMS updates player's jackpot eligibility status
   JMS confirms update to TGMS and PMS
7. Mystery Jackpot Integration:
   JMS includes player in appropriate tier for Mystery Jackpot draws
   During Mystery Jackpot events, JMS considers player's upgraded eligibility
8. Session Conclusion and Data Persistence:
   Upon player cash-out, ETGT sends session summary to TGMS
   TGMS updates PMS with challenge completions and gameplay data
   PMS stores updated player profile for future sessions
9. Reporting and Analysis:
   CMS generates reports on challenge completion rates and popularity
   Casino management uses data to refine challenges and difficulty levels

This procedural flow ensures that in-game challenges are seamlessly integrated into the DETG ecosystem, providing real-time tracking, instant reward delivery, and maintaining data integrity across all relevant systems.

Noteworthy Aspects and Features: The Achievement of In-Game Challenges eligibility criteria introduces several innovative aspects to the DETG and Mystery Jackpot systems:
1. Skill-Based Jackpot Eligibility: This system uniquely ties jackpot eligibility to player skill and game knowledge, rather than purely random chance or bet size.
2. Dynamic Difficulty Scaling: Challenges may be dynamically adjusted based on player skill levels, ensuring engaging experiences for both novices and experts.
3. Cross-Session Challenge Persistence: Players may work towards long-term challenges across multiple gaming sessions, encouraging return visits.
4. Social Proof and Competition: Visible challenge progressions may create a sense of competition among players, enhancing the social aspect of DETGs.
5. Granular Player Profiling: The system provides deep insights into player behaviors, strategies, and skill progression over time.
6. Adaptive Marketing Tool: Casinos may use the challenge system to promote specific games or playing styles by adjusting challenge criteria and rewards.
7. Regulatory Compliance: By basing jackpot eligibility on demonstrable player actions, this system may satisfy regulatory requirements in jurisdictions that may require skill elements in gaming.

### Eligibility Criteria 40—Jackpot Contribution Based on Game Types

Description and Implementation: The Jackpot Contribution Based on Game Types eligibility criteria introduces a dynamic system where a player's chances of qualifying for Mystery Jackpot participation are weighted according to the house edge of the games they choose to play. This innovative approach encourages players to engage with a diverse range of games while providing casinos with a balanced method of jackpot contribution that aligns with their profitability goals.

Implementation of this system may require integration between the individual Electronic Table Game Terminals (ETGTs), the Table Game Management System (TGMS), and a newly introduced Game Edge Calculation Module (GECM). The GECM maintains an up-to-date database of house edge percentages for all available games, considering factors such as specific rule variations and optimal player strategies.

As players engage with different games across the casino floor, the system tracks their play in real-time. The GECM calculates a weighted contribution score based on the amount wagered and the house edge of each game played. Games with a higher house edge contribute more significantly to the player's Mystery Jackpot eligibility score.

This score is continuously updated and displayed to the player, either as a numerical value or as a visual representation (e.g., a progress bar towards jackpot eligibility). Once a player's score reaches a predetermined threshold, they become eligible for Mystery Jackpot participation.

### Benefits to Players:

1. Increased transparency in jackpot contribution mechanics
2. Motivation to explore a wider variety of games
3. Faster accumulation of jackpot eligibility when playing higher house edge games
4. Visual feedback on progress towards jackpot eligibility
5. Potential for strategic gameplay to optimize both enjoyment and jackpot chances

### Benefits to Casinos:

1. Encouragement of play on higher house edge games
2. Balanced distribution of jackpot eligibility across game types
3. Increased player engagement with a broader game selection
4. Potential for increased overall gaming revenue
5. Data-driven insights into player game preferences and betting patterns
6. Flexibility to adjust contribution rates to promote specific games or events

Example Walk-through Scenario: Michael, a regular at the City of Dreams casino in Macau, decides to try his luck at the electronic gaming area. As he approaches the DETGs, he notices a new display above the gaming floor: “Mystery Jackpot Eligibility—Play More, Win More!”

Intrigued, Michael sits at a digital roulette table and inserts his player card. The screen welcomes him and explains the new Jackpot Contribution system. It shows that roulette has a moderate contribution rate towards Mystery Jackpot eligibility.

As Michael plays roulette, he watches his eligibility score slowly increase. After an hour, his score has reached 35 out of the 100 points needed for jackpot eligibility. Curious to see how other games compare, he moves to a DETG offering Sic Bo.

Upon starting play at Sic Bo, Michael notices his eligibility score is increasing much faster due to the game's higher house edge. Within 30 minutes, his score jumps to 65 points. The system sends a notification: “You're well on your way to Mystery Jackpot eligibility! Try our new Ultimate Texas Hold'em for even faster point accumulation!”

Excited by his progress, Michael decides to give the new game a try. As he plays Ultimate Texas Hold'em, his point accumulation accelerates dramatically. Within just 15 minutes, his score crosses the 100-point threshold. The screen erupts in a celebratory animation, announcing his eligibility for the next Mystery Jackpot draw.

Now eligible, Michael continues to play, knowing that each bet not only gives him a chance to win in the base game but also enters him into the Mystery Jackpot pool. This dual opportunity keeps him engaged and excited throughout his gaming session.

### Example System Procedural Flow:

1. System Initialization:
   GECM loads current house edge data for all games
   TGMS syncs with GECM to receive updated contribution rates
2. Player Session Start:
   Player inserts card into ETGT
   ETGT queries Player Management System (PMS) for player data
   PMS returns current eligibility score and play history
3. Game Selection and Contribution Calculation:
   Player selects a game on the ETGT
   ETGT notifies TGMS of game choice
   TGMS queries GECM for current game's contribution rate
   GECM returns rate based on game type and current rules
4. Real-time Eligibility Tracking:
   ETGT sends bet amounts and game outcomes to TGMS
   TGMS calculates contribution based on wagers and GECM rate
   TGMS updates player's eligibility score in real-time
   ETGT displays updated score to player
5. Multi-game Tracking:
   As player switches games, TGMS requests new rates from GECM
   Contribution calculations adjust automatically for each game
6. Eligibility Threshold Monitoring:
   TGMS continuously compares player's score to eligibility threshold
   Upon reaching threshold, TGMS notifies Jackpot Management System (JMS)
   JMS updates player's status for Mystery Jackpot participation
7. Mystery Jackpot Integration:
   JMS includes eligible players in Mystery Jackpot draws
   If player wins, JMS notifies TGMS and PMS
8. Session End and Data Persistence:
   Player cashes out or removes card
   ETGT sends final session data to TGMS
   TGMS updates PMS with new eligibility score and play history
   PMS stores data for future sessions and analysis
9. Periodic System Updates:
   Casino management reviews game performance data
   GECM is updated with any changes to game rules or house edges
   Contribution rates are adjusted in TGMS and propagated to all ETGTs

This procedural flow ensures accurate, real-time tracking of player contributions across multiple game types, seamlessly integrating the Jackpot Contribution Based on Game Types eligibility criteria into the existing DETG ecosystem.

Noteworthy Aspects and Features: The Jackpot Contribution Based on Game Types eligibility criteria introduces several innovative features to the DETG and Mystery Jackpot landscape:
1. Dynamic Eligibility Scoring: This system creates a fluid, real-time measure of jackpot eligibility that responds instantly to player choices and actions.
2. House Edge Alignment: By tying jackpot eligibility to house edge, the system naturally balances jackpot distribution with casino profitability.
3. Game Exploration Incentive: Players are encouraged to try a variety of games, potentially discovering new favorites and increasing overall engagement.
4. Transparent Contribution Mechanism: Unlike hidden jackpot contribution systems, this approach gives players clear visibility into how their actions affect their jackpot chances.
5. Flexible Marketing Tool: Casinos may easily adjust contribution rates to promote new games or reinvigorate interest in existing ones.
6. Strategic Depth: Knowledgeable players may optimize their play for both game enjoyment and jackpot eligibility, adding a layer of strategy to their casino experience.
7. Data-Rich Player Profiling: The system provides detailed insights into player game preferences, risk appetites, and decision-making patterns.

### Eligibility Criteria 41—Hourly Winners Club

Description and Implementation: The Hourly Winners Club eligibility criteria introduces a dynamic, time-based system for Mystery Jackpot participation that rewards the most successful players within defined hourly periods. This innovative approach adds an element of competition to the gaming floor, encouraging active play and creating regular peaks of excitement throughout the casino's operating hours.

Implementation of this system may require seamless integration between individual Electronic Table Game Terminals (ETGTs), the Table Game Management System (TGMS), and a newly introduced Hourly Performance Tracking Module (HPTM). The HPTM is responsible for monitoring and ranking player performance across all connected DETGs in real-time.

At the start of each hour, the HPTM initiates a new tracking period. Throughout the hour, it continuously updates a leaderboard based on players' net winnings (total wins minus total bets). This leaderboard is displayed on large screens throughout the gaming area and on individual ETGTs, creating a sense of competition and urgency among players.

As the hour draws to a close, the system identifies the top performers—for example, the top 10 players with the highest net winnings for that hour. These players are then granted eligibility for a special Hourly Winners Club Mystery Jackpot, which is drawn immediately after the hour concludes.

The system also incorporates a rolling eligibility feature, where strong performances may grant extended eligibility. For instance, a top-3 finish may grant eligibility for the next 3 hourly jackpots, ensuring that exceptional play is adequately rewarded even if the player decides to take a break.

### Benefits to Players:

1. Regular opportunities to qualify for exclusive jackpots
2. Added excitement and competitive element to standard gameplay
3. Recognition for successful play, independent of long-term luck
4. Clear, achievable short-term goals during gaming sessions
5. Potential for strategic timing of play to maximize chances of making the Hourly Winners Club

### Benefits to Casinos:

1. Increased player engagement and time on device
2. Creation of regular excitement peaks, improving overall casino atmosphere
3. Encouragement of more active play and potentially higher betting
4. Attraction of competitive players who enjoy public recognition
5. Flexible system for running promotions and special events
6. Rich data source for understanding peak playing hours and player behaviors

Example Walk-through Scenario: Sarah enters the Wynn Palace casino in Macau at 7:45 PM, noticing large displays showing a countdown timer and a leaderboard titled “Hourly Winners Club.” Intrigued, she approaches a DETG offering electronic baccarat and inserts her player card.

The ETGT screen welcomes Sarah and explains the Hourly Winners Club concept. With 15 minutes left in the current hour, Sarah decides to start playing, hoping to position herself well for the next full hour of competition.

As Sarah plays, she sees her name appear on the leaderboard displayed on her ETGT screen. The casino-wide displays also update, showing her climbing the ranks. When the clock strikes 8:00 PM, a celebratory animation plays across all screens, announcing the winners of the previous hour's contest. Sarah notices she finished 15th, just missing out on eligibility.

Determined to make the next hour's cut, Sarah continues playing. She adjusts her strategy, taking calculated risks to maximize her winnings. The ETGT provides real-time updates on her position in the hourly contest, adding to the excitement of each hand.

Around 8:30 PM, Sarah hits a lucky streak, winning several high-stakes hands in quick succession. Her name shoots up the leaderboard, now sitting in 3rd place. Other players, noticing her success, begin to gather around, adding to the competitive atmosphere.

As the 9:00 PM deadline approaches, Sarah finds herself in a tight race for the top spots. With just minutes to go, she risks a large bet and wins, securing her position in 2nd place as the hour closes.

Immediately after 9:00 PM, all ETGTs display the final leaderboard. Sarah's name is highlighted, confirming her eligibility for the Hourly Winners Club Mystery Jackpot. The system announces that the top 3 finishers will also be eligible for the next two hourly draws.

A brief countdown ensues, building anticipation for the Mystery Jackpot draw. When the winning ETGT is selected, it turns out to be Sarah's machine. Her screen erupts with animations and sounds, announcing her as the Hourly Winners Club Mystery Jackpot recipient. The win is also broadcast on the casino-wide displays, drawing applause from nearby players.

Energized by her win and knowing she's eligible for the next two hourly draws, Sarah decides to continue playing, hoping to maintain her winning streak and potentially score another jackpot.

### Example System Procedural Flow:

1. Hourly Cycle Initialization:
   Hourly Performance Tracking Module (HPTM) initiates new tracking period
   HPTM resets leaderboard and notifies Table Game Management System (TGMS)
   TGMS broadcasts new period start to all connected ETGTs
2. Player Session Start:
   Player inserts card into ETGT
   ETGT queries Player Management System (PMS) for player data
   ETGT registers player with HPTM for current hour's contest
3. Real-time Performance Tracking:
   ETGT sends bet amounts and game outcomes to TGMS
   TGMS calculates net winnings and forwards to HP™
   HPTM updates player's position on leaderboard
   HPTM pushes leaderboard updates to display systems and ETGTs
4. Periodic Leaderboard Updates:
   HPTM sends leaderboard updates to TGMS every minute
   TGMS broadcasts updates to all ETGTs and central displays
   ETGTs refresh individual player standings
5. Hour Conclusion and Winner Determination:
   HPTM finalizes leaderboard at hour's end
   Top performers (e.g., top 10) are flagged as eligible for Hourly Winners Club
   HPTM notifies Jackpot Management System (JMS) of eligible players
6. Mystery Jackpot Draw:
   JMS conducts random draw among eligible ETGTs
   Winning ETGT and player are identified
   JMS notifies TGMS and PMS of jackpot win
7. Win Announcement and Payout:
   TGMS broadcasts win announcement to all ETGTs and displays
   Winning ETGT triggers celebration sequence
   JMS initiates payout process through casino accounting system
8. Extended Eligibility Processing:
   HPTM flags top performers for extended eligibility
   HPTM communicates extended eligibility to JMS and PMS
   PMS updates player profiles with extended eligibility status
9. Data Analysis and Reporting:
   HPTM generates hourly performance reports
   Reports are sent to casino management for analysis and strategy adjustment

This procedural flow ensures smooth operation of the Hourly Winners Club, from real-time performance tracking to jackpot award and extended eligibility processing.

Noteworthy Aspects and Features: The Hourly Winners Club eligibility criteria introduces several innovative aspects to the DETG and Mystery Jackpot systems:
1. Time-Based Competition: Introduces a regular, predictable cycle of competition and reward, creating sustained excitement on the gaming floor.
2. Performance-Based Eligibility: Rewards skillful or lucky play within a defined timeframe, rather than relying solely on random chance or long-term play volume.
3. Public Recognition System: Leverages the power of social proof and competition by publicly displaying player performance.
4. Short-Term Goal Setting: Provides players with achievable, hour-long goals, encouraging more focused and engaged play.
5. Flexible Promotion Tool: Allows casinos to easily adjust eligibility criteria, prize structures, and timeframes to suit different events or target demographics.
6. Cross-Game Comparison: Enables fair competition across different game types by focusing on net winnings rather than game-specific metrics.
7. Extended Eligibility Feature: Rewards top performers with prolonged jackpot eligibility, encouraging continued play and return visits.

### Eligibility Criteria 42—Customizable Player Preferences

Description and Implementation: The Customizable Player Preferences eligibility criteria introduces a highly personalized approach to Mystery Jackpot participation in Live Dealer Game Tables (LDGTs) and Dealer-controlled Electronic Table Games (DETGs). This innovative system allows players to tailor their jackpot experience by selecting from a menu of eligibility options, side bets, and risk-reward profiles that best suit their individual playing style and preferences.

Implementation of this system may require the integration of a new Player Preference Module (PPM) into the existing DETG software and Table Game Management System (TGMS). The PPM interfaces with individual Electronic Table Game Terminals (ETGTs) to present players with a range of customizable options upon login or at designated intervals during their gaming session.

These options may include:
1. Jackpot entry frequency (e.g., every hand, every 10 hands, or based on cumulative bet amount)
2. Risk-reward profile (e.g., higher risk for larger jackpots vs. lower risk for more frequent, smaller wins)
3. Specific game conditions for jackpot eligibility (e.g., only on natural blackjacks or when betting on Player in baccarat)
4. Automatic side bet allocation (e.g., percentage of main bet automatically allocated to jackpot eligibility)
5. Jackpot notification preferences (e.g., subtle vs. prominent display of near misses and wins)

The system stores these preferences in the Player Management System (PMS) and applies them dynamically during gameplay. The TGMS continuously monitors play and compares it against the player's chosen criteria, triggering Mystery Jackpot eligibility when conditions are met.

### Benefits to Players:

1. Highly personalized gaming experience
2. Ability to align jackpot participation with individual risk tolerance and playing style
3. Increased sense of control over their gaming destiny
4. Opportunity to experiment with different strategies for jackpot eligibility
5. Reduced cognitive load during gameplay as preferred options are automatically applied

### Benefits to Casinos:

1. Enhanced player engagement through personalization
2. Increased player loyalty due to customized experiences
3. Rich data source for understanding player preferences and behaviors
4. Ability to offer targeted promotions based on chosen preferences
5. Potential for increased jackpot participation across diverse player segments
6. Flexibility to introduce new preference options to keep the gaming experience fresh

Example Walk-through Scenario: David, a regular at the MGM Cotai in Macau, approaches a DETG offering multiple games. Upon inserting his player card, he's greeted with a “Welcome Back” message and a prompt to review his Jackpot Preference settings.

David navigates to the preference menu, where he sees his current settings: moderate risk profile, jackpot eligibility on every 5th hand, and automatic 5% side bet for jackpots. Feeling a bit more adventurous today, he adjusts his settings to a higher risk profile, eligibility on every hand, and increases his automatic side bet to 10%.

As David begins playing baccarat, he notices that his ETGT screen now displays a more prominent jackpot tracker, reflecting his higher risk preference. After each hand, the screen briefly flashes his current jackpot eligibility status.

During his session, David hits a streak of wins. The system, recognizing this pattern, suggests a temporary boost to his risk profile. David accepts, and for the next 30 minutes, he's eligible for even larger Mystery Jackpots, adding extra excitement to his hot streak.

Later, David switches to blackjack. The system smoothly transitions his preferences to this new game, adjusting the eligibility criteria to match blackjack gameplay. Now, he's eligible for Mystery Jackpots on any blackjack hand where he has a natural 21.

Throughout his gaming session, David receives subtle notifications about near-misses and potential jackpot opportunities, keeping him engaged without being intrusive. When he does hit a Mystery Jackpot trigger, the celebration is tailored to his pre-selected preference for moderate audiovisual feedback.

As David prepares to leave, the system prompts him to save his new preferences or revert to his previous settings. He chooses to save, ensuring his next visit will start with his updated, personalized jackpot experience.

### Example System Procedural Flow:

1. Player Login and Preference Retrieval:
   Player inserts card into ETGT
   ETGT queries Player Management System (PMS) for player data including saved preferences
   Player Preference Module (PPM) loads preferences into active memory
2. Preference Review and Update:
   ETGT displays current preferences to player
   Player reviews and optionally updates preferences
   PPM validates and saves any changes to PMS
   PPM notifies TGMS of active preference set
3. Game Initiation with Custom Settings:
   Player selects game on ETGT
   TGMS applies player's preferences to chosen game
   ETGT configures display and betting options based on preferences
4. Dynamic Eligibility Tracking:
   ETGT sends game actions and outcomes to TGMS
   TGMS compares activity against player's eligibility criteria
   PPM continuously calculates and updates jackpot eligibility
5. Automated Side Bet Management:
   TGMS applies predetermined side bet percentage to each wager
   ETGT displays side bet amount and updates credit balance
6. Real-time Preference Suggestions:
   TGMS analyzes player's performance and betting patterns
   PPM generates dynamic preference adjustment suggestions
   ETGT presents suggestions to player for approval
7. Cross-Game Preference Application:
   Player switches to a different game on ETGT
   PPM adapts saved preferences to new game context
   TGMS updates eligibility criteria for new game type
8. Mystery Jackpot Integration:
   When eligibility criteria are met, TGMS notifies Jackpot Management System (JMS)
   JMS includes player in appropriate Mystery Jackpot pools
   If jackpot is won, JMS signals TGMS for customized win celebration
9. Session End and Preference Confirmation:
   Player initiates cash-out process
   PPM prompts for confirmation of any changed preferences
   Final preferences are saved to PMS for future sessions
10. Data Analysis and Preference Optimization:
   System aggregates anonymized preference and performance data
   Casino management analyzes trends to refine preference options and default settings

This procedural flow ensures a seamless, personalized Mystery Jackpot experience that adapts to player preferences across multiple games and sessions.

Noteworthy Aspects and Features: The Customizable Player Preferences eligibility criteria introduces several innovative aspects to the DETG and Mystery Jackpot systems:
1. Player-Centric Design: Shifts control to the player, allowing them to tailor their jackpot experience to personal preferences.
2. Dynamic Risk Profiling: Enables players to adjust their risk-reward balance in real-time, adapting to their current mood or gaming performance.
3. Cross-Game Continuity: Maintains a consistent jackpot experience across different game types while respecting game-specific mechanics.
4. Intelligent Suggestion System: Utilizes player performance data to offer relevant preference adjustments, enhancing the gaming experience.
5. Granular Control: Offers unprecedented levels of customization in jackpot participation, from entry frequency to celebration intensity.
6. Behavioral Insight Generator: Provides casinos with rich, actionable data on player preferences and decision-making patterns.
7. Adaptive Marketing Platform: Allows for highly targeted promotions and bonuses based on individual player preferences and behaviors.
8. Regulatory Compliance Tool: By clearly displaying and requiring active player choices, this system may help meet responsible gaming requirements in various jurisdictions.

### Eligibility Criteria 43—Specific Bet Denomination

Description and Implementation: This eligibility criteria establishes that players who place bets using specified denominations (e.g., $1, $5) may become eligible for Mystery Jackpot participation at live dealer game tables (LDGTs) and live Dealer-controlled Electronic Table Games systems (DETGs). The system tracks the denominations of bets placed by each player during their gaming session. When a player consistently uses the predetermined bet denominations, they qualify for Mystery Jackpot eligibility.

For implementation, the DETG system is programmed to recognize and flag specific bet denominations. Each Electronic Table Game Terminal (ETGT) is equipped with sensors or software that accurately detects and records the value of chips or digital currency used for betting. The system may require a certain number of bets at the specified denomination within a set time frame or across a certain number of hands to trigger eligibility. For example, placing 10 consecutive $5 bets or 20 $1 bets within an hour may qualify a player.

This criteria may be applied flexibly across different game types, allowing casinos to tailor the qualifying denominations to suit various player segments and game stakes. The system may also incorporate a tiered approach, where higher denominations grant eligibility for larger Mystery Jackpots.

### Benefits to Players:

1. Encourages strategic betting behavior
2. Provides clear, attainable goals for jackpot eligibility
3. Adds excitement to standard bet placement
4. Rewards consistent play at specific stake levels

### Benefits to Casinos:

1. Increases player engagement and time on device
2. Encourages higher denomination bets
3. Allows for targeted marketing of specific player segments
4. Provides data on betting patterns and preferences
5. Potentially increases overall bet volume and house edge

Example Walk-through Scenario: John enters the casino and approaches a DETG offering electronic baccarat. He inserts his player card into the ETGT and is greeted with a message: “Place five consecutive $5 bets to qualify for our Mystery Jackpot!” Intrigued, John decides to participate.

He begins his session by placing a $5 bet on the Player hand. The ETGT registers this bet, and a small indicator appears on his screen, showing “⅕ qualifying bets placed.” John continues to play, placing $5 bets for the next four hands. With each bet, the indicator updates, and after the fifth consecutive $5 bet, a celebratory animation appears on his screen, announcing, “Congratulations! You are now eligible for the Mystery Jackpot!” As John continues to play, he notices that maintaining his $5 bets keeps him eligible for the Mystery Jackpot.

Occasionally, he receives prompts encouraging him to maintain his betting pattern to stay in the running. During his session, John witnesses another player at a nearby ETGT win a Mystery Jackpot, which further motivates him to continue playing.

After an hour of play, John decides to increase his bets to $10. The system recognizes this change and presents him with a new opportunity: “You've unlocked a new tier! Place three $10 bets to qualify for our Premium Mystery Jackpot!” Excited by the prospect of a larger potential win, John complies.

Throughout his gaming session, John finds himself more engaged and strategic about his bet placement. He appreciates the clear goals and the added layer of excitement to his usual gameplay. Even when experiencing a losing streak, the potential for a Mystery Jackpot win keeps him invested in the game.

As John prepares to end his session, he receives a final message thanking him for his play and reminding him of his continued Mystery Jackpot eligibility on his next visit if he maintains similar betting patterns. This experience leaves John feeling valued and eager to return for another chance at the Mystery Jackpot.

### Example System Procedural Flow:

1. Player Authentication:
   Player inserts card or enters credentials at ETGT
   ETGT sends player ID to central server
   Server validates player and retrieves profile
2. Eligibility Criteria Configuration:
   Server loads current Mystery Jackpot eligibility criteria
   Criteria for specific bet denominations are transmitted to ETGT
3. Bet Placement and Tracking:
   Player places a bet on the ETGT
   ETGT's bet sensor detects chip value or digital bet amount
   Bet information (amount, time, game type) is recorded locally
4. Real-time Eligibility Assessment:
   ETGT compares bet amount to specified denominations
   If match found, bet counter for that denomination is incremented
   ETGT checks if required number of bets at denomination is reached
5. Eligibility Status Update:
   If criteria met, ETGT sends eligibility achievement message to server
   Server updates player's jackpot eligibility status in central database
   Server sends confirmation to ETGT
6. Player Notification:
   ETGT displays eligibility status and congratulatory message to player
   Optional: ETGT triggers audio/visual cues to enhance experience
7. Continuous Monitoring:
   ETGT continues to track bets and maintain eligibility status
   If player deviates from eligible denominations, ETGT notifies server
   Server updates eligibility status accordingly
8. Mystery Jackpot Trigger:
   Central server randomly selects a jackpot win event
   Server checks all eligible players across connected ETGTs
   If winning event corresponds to an eligible player, jackpot is awarded
9. Jackpot Award Process:
   Server sends jackpot win notification to specific ETGT
   ETGT displays win animation and amount to player
   Server updates financial systems and jackpot pool
10. Session Summary and Retention:
   Upon player logout, ETGT sends session data to server
   Server analyzes betting patterns and eligibility status
   System generates personalized offers based on denomination preferences
11. Reporting and Analysis:
   Casino management may access reports on denomination-based eligibility
   Data used to refine criteria and optimize jackpot strategies

Noteworthy Aspects and Features: This eligibility criteria introduces several novel aspects to Mystery Jackpot implementations in DETGs:
1. Dynamic Denomination Tracking: Unlike traditional systems that may only track total bet amounts, this system actively monitors specific denominations, allowing for more nuanced player engagement strategies.
2. Tiered Eligibility Structure: By offering different jackpot tiers based on bet denominations, the system creates a multi-layered incentive structure that caters to various player segments simultaneously.
3. Real-time Adaptive Messaging: The system's ability to provide immediate feedback and new goals based on betting behavior creates a highly interactive and personalized gaming experience.
4. Cross-Session Eligibility Retention: By remembering a player's eligibility status between sessions, the system encourages return visits and consistent betting patterns.
5. Data-Driven Criteria Refinement: The detailed tracking of denomination-based betting patterns provides casinos with valuable insights for optimizing their jackpot strategies and overall game offerings.
6. Seamless Integration with Game Flow: This criteria enhances the gaming experience without disrupting the specific gameplay, making it particularly suitable for traditional table game enthusiasts who may be skeptical of overly complex bonus features.

### Eligibility Criteria 44—Gaming Streak Milestone

Description and Implementation: This eligibility criteria establishes that players who achieve a specific gaming streak, such as consecutive wins or losses, may qualify for Mystery Jackpot participation at live dealer game tables (LDGTs) and live Dealer-controlled Electronic Table Games systems (DETGs). The system tracks the outcomes of each player's games in real-time, identifying and recording streaks of wins, losses, or specific game outcomes.

Implementation involves sophisticated tracking software integrated into each Electronic Table Game Terminal (ETGT) and the central casino management system. The software monitors every game result for each player, maintaining a running tally of consecutive outcomes. Streaks may be defined in various ways, such as five consecutive wins, ten consecutive losses, or even more complex patterns like alternating wins and losses over a set number of games.

The criteria may be customized for different game types. For example, in blackjack, a streak may be defined as winning three hands in a row with a natural blackjack. In roulette, it may be hitting the same color five times consecutively. The system may also incorporate different levels of streaks, with longer or more difficult streaks qualifying for larger Mystery Jackpots.

### Benefits to Players:

1. Adds excitement and anticipation to every hand or spin
2. Provides consolation for losing streaks
3. Encourages longer play sessions
4. Offers an additional way to win beyond the base game

### Benefits to Casinos:

1. Increases player engagement and time on device
2. Encourages players to continue through both winning and losing streaks
3. Provides valuable data on player behavior and game volatility
4. Differentiates the casino's offerings from competitors
5. Potentially increases overall bet volume

Example Walk-through Scenario: Sarah sits down at a DETG offering electronic roulette. Upon inserting her player card, she receives a message: “Hit 5 consecutive odd numbers to qualify for our Odd Streak Mystery Jackpot!” Intrigued, Sarah begins to play.

She places her first bet on odd numbers. The ball lands on 7, and Sarah wins. An indicator appears on her screen: “Odd Streak: ⅕”. Excited, Sarah continues betting on odd numbers. The next spin lands on 15, updating her streak to ⅖. The third spin hits 31, and Sarah's anticipation grows.

On the fourth spin, the ball lands on 26, an even number. Sarah's streak resets, but she's not discouraged. The system displays a new message: “Tough luck! But remember, any 5-spin streak qualifies you for our Mystery Jackpot. Keep playing!”

Sarah continues playing, and after a few more spins, she hits an even number streak. On her third consecutive even number, the system notifies her: “Even Streak: ⅗—You're close to Mystery Jackpot eligibility!” Two more even numbers follow, and Sarah's screen erupts in celebration: “Congratulations! Your 5-spin Even Streak has qualified you for the Mystery Jackpot!” Sarah is thrilled, knowing that she now has a chance at a substantial bonus win.

As she continues to play, Sarah notices that her Mystery Jackpot eligibility remains active. She's informed that any new streak will increase her chances of winning. This encourages her to keep playing, rotating her bets between odd and even numbers, always anticipating the next streak.

Throughout her session, Sarah experiences the thrill of building streaks and the suspense of potentially triggering the Mystery Jackpot. Even during periods of losses, she remains engaged, knowing that a losing streak may turn into jackpot eligibility.

After an exciting session, Sarah cashes out, feeling satisfied with her play and eager to return for another chance at streak-based Mystery Jackpot wins.

### Example System Procedural Flow:

1. Player Identification:
   Player inserts card or enters credentials at ETGT
   ETGT sends player ID to central server
   Server authenticates player and loads profile
2. Streak Criteria Initialization:
   Server transmits current streak-based eligibility criteria to ETGT
   ETGT initializes streak counters for the player
3. Game Play and Outcome Tracking:
   Player places bet and game commences
   ETGT records game outcome
   Outcome is sent to server for central tracking
4. Streak Analysis:
   ETGT updates local streak counters based on game outcome
   Server simultaneously updates central streak record
   Both systems check if current streak meets eligibility criteria
5. Eligibility Determination:
   If streak criteria met, ETGT flags player as eligible
   ETGT sends eligibility status update to server
   Server confirms and updates central eligibility database
6. Player Notification:
   ETGT displays streak progress and eligibility status
   Upon achieving eligibility, ETGT triggers celebration animation
   Server pushes notification to player's mobile app (if applicable)
7. Continuous Monitoring:
   ETGT and server continue tracking game outcomes
   Eligibility status is refreshed with each game
   Multiple streak types may be tracked simultaneously
8. Mystery Jackpot Trigger:
   Central server randomly initiates jackpot award event
   Server scans all eligible players across connected ETGTs
   If trigger corresponds to an eligible player, jackpot is awarded
9. Jackpot Award Process:
   Server sends win notification to specific ETGT
   ETGT displays win animation and amount
   Server updates financial systems and jackpot pool
10. Streak Reset and Continuation:
   After jackpot award or streak break, counters are reset
   New streak opportunities are immediately presented to player
11. Session Analysis:
   Upon session end, ETGT sends comprehensive streak data to server
   Server analyzes streak patterns for player profiling
12. Reporting and Optimization:
   Casino management receives reports on streak-based gameplay
   Data used to refine criteria and adjust jackpot frequencies

Noteworthy Aspects and Features: This eligibility criteria introduces several innovative elements to Mystery Jackpot implementations in DETGs:
1. Multi-dimensional Streak Tracking: The system may simultaneously monitor various types of streaks, offering diverse paths to jackpot eligibility within a single gaming session.
2. Adaptive Difficulty Scaling: Streak requirements may be dynamically adjusted based on game volatility, player skill level, or casino occupancy, ensuring optimal engagement.
3. Negative Streak Utilization: By making losing streaks eligible for jackpots, the system maintains player interest during downturns, potentially reducing player churn.
4. Cross-Game Streak Continuity: Streaks may potentially be carried across different games within the DETG ecosystem, encouraging players to explore various offerings.
5. Behavioral Reinforcement: The system leverages the psychological appeal of streaks to influence player behavior, potentially extending play sessions.
6. Real-time Achievement System: By treating streaks as achievements, the system gamifies the experience beyond the base game, appealing to achievement-oriented players.

### Eligibility Criteria 45—Participation in Special E Vents

Description and Implementation: This eligibility criteria establishes that players attending casino events (e.g., celebrity dealer nights, tournaments, holiday promotions) may become eligible for Mystery Jackpot participation at live dealer game tables (LDGTs) and live Dealer-controlled Electronic Table Games systems (DETGs). The system recognizes and rewards players who engage with the casino's special events, creating an additional incentive for event attendance and participation.

Implementation may require integration between the casino's event management system, player tracking system, and the DETG network. Each special event is assigned a unique identifier in the system. When players check in to an event, their attendance is logged in their player profile. Electronic Table Game Terminals (ETGTs) are programmed to recognize event attendance and automatically flag participating players for Mystery Jackpot eligibility.

The criteria may be customized for different types of events. For example, attending a celebrity dealer night may grant immediate Mystery Jackpot eligibility, while participation in a multi-day tournament may increase eligibility chances progressively each day. The system may also incorporate tiered eligibility, where more exclusive or high-stakes events grant access to larger Mystery Jackpots.

### Benefits to Players:

1. Adds value to event attendance
2. Provides exclusive gaming opportunities
3. Enhances the overall casino experience
4. Rewards loyalty and engagement with casino activities

### Benefits to Casinos:

1. Increases attendance and participation in special events
2. Enhances marketing effectiveness for promotions
3. Encourages players to engage with multiple casino offerings
4. Creates opportunities for data collection on event preferences
5. Differentiates the casino's entertainment value proposition

Example Walk-through Scenario: The Golden Palace Casino is hosting a week-long “Summer Splash” event, featuring celebrity dealers, exclusive tournaments, and nightly entertainment. Upon arrival, Maria checks in at the event registration desk, where her player card is scanned, logging her attendance in the system.

Maria decides to try her luck at the DETGs. As she approaches an electronic baccarat table and inserts her player card, she's greeted with a special message: “Welcome to Summer Splash! Your event attendance has qualified you for our Exclusive Event Mystery Jackpot. Every hand you play has a chance to trigger a jackpot win!” Excited by this unexpected bonus, Maria begins to play. She notices a special “Event Jackpot Eligible” indicator on her screen, confirming her special status. As she plays, occasional animations remind her of her eligibility, maintaining her excitement.

During her session, Maria is invited via a popup message to join a celebrity-dealt hand at a nearby LDGT. The message informs her that participation will boost her Mystery Jackpot odds. Maria accepts and enjoys a few hands with the celebrity dealer, her elevated jackpot status following her seamlessly between the DETG and LDGT.

Returning to the DETG, Maria finds her Mystery Jackpot odds have indeed increased, represented by a “Jackpot Heat Meter” on her screen. This encourages her to continue playing, enjoying both the base game and the anticipation of a potential jackpot win.

As the evening progresses, Maria attends other event activities, each one logged in her profile. Upon returning to gaming, she discovers her continued event participation has unlocked eligibility for an even larger “VIP Event Mystery Jackpot.”

Throughout the week, Maria finds herself more engaged with both the event activities and the gaming options, always aware that her participation is boosting her chances for a significant win. Even on days when her gaming luck is down, the persistent eligibility for the Event Mystery Jackpot keeps her excited and looking forward to her next session.

By the end of the “Summer Splash” week, Maria has had a thoroughly enjoyable experience, feeling rewarded for her event participation regardless of whether she ultimately wins a Mystery Jackpot. The integrated event and gaming experience leaves her eager for the casino's next special event.

### Example System Procedural Flow:

1. Event Setup:
   Casino management creates event in Event Management System (EMS)
   EMS assigns unique event ID and sets eligibility parameters
   Parameters are transmitted to central casino server
2. Player Check-in:
   Player arrives and checks in at event registration
   Staff scans player's card or enters ID into EMS
   EMS sends attendance data to central player tracking system
3. Eligibility Activation:
   Player approaches ETGT and inserts player card
   ETGT queries central server for player status
   Server confirms event attendance and flags player as jackpot-eligible
   ETGT receives eligibility confirmation and activates special event mode
4. Player Notification:
   ETGT displays welcome message and eligibility status to player
   Special event jackpot information is presented on screen
5. Gameplay Monitoring:
   Player begins gaming session
   ETGT tracks gameplay data and sends to central server
   Server updates player's event participation metrics
6. Cross-Platform Synchronization:
   Player moves between ETGTs and LDGTs
   Central server maintains eligibility status across all platforms
   Each new terminal queries server for current player status
7. Event Activity Tracking:
   EMS logs player participation in various event activities
   Data is sent to central server to update player profile
   Server recalculates Mystery Jackpot eligibility based on participation level
8. Dynamic Odds Adjustment:
   Server analyzes overall event participation for each player
   Jackpot eligibility odds are adjusted based on participation metrics
   Updated odds are transmitted to player's current gaming terminal
9. Mystery Jackpot Trigger:
   Random Number Generator (RNG) on central server initiates jackpot trigger
   Server scans all eligible players, weighing odds based on participation
   If trigger corresponds to an eligible player, jackpot is awarded
10. Jackpot Award Process:
   Server sends win notification to player's current terminal
   Terminal displays win animation and amount
   Server updates financial systems, jackpot pool, and player's history
11. Continuous Eligibility Updates:
   System continuously monitors player's event engagement
   Eligibility status and odds are updated in real-time
   Players are notified of status changes and new opportunities
12. Post-Event Analysis:
   At event conclusion, server compiles comprehensive participation data
   Analysis of event impact on gameplay and jackpot engagement is generated
   Results are used to optimize future event-based promotions

Noteworthy Aspects and Features: This eligibility criteria introduces several innovative elements to Mystery Jackpot implementations in DETGs:
1. Integrated Event-Gaming Experience: By directly linking special events to jackpot eligibility, the system creates a seamless, immersive casino experience that extends beyond the gaming floor.
2. Dynamic Eligibility Scaling: The ability to adjust jackpot odds based on event participation encourages broader engagement with casino offerings.
3. Cross-Platform Compatibility: The system maintains eligibility across various gaming platforms (ETGTs, LDGTs), providing a cohesive experience as players explore different game types.
4. Tiered Event-Based Jackpots: By offering different levels of jackpots tied to event exclusivity or participation levels, the system caters to various player segments simultaneously.
5. Real-time Engagement Metrics: The continuous tracking and updating of event participation provides valuable, actionable data on player preferences and behaviors.
6. Flexible Promotion Integration: The system allows for easy integration of various promotional events into the gaming experience, enhancing marketing effectiveness.

### Eligibility Criteria 46˜Slot Machine and Table Game Hybrid Participation

Description and Implementation: This eligibility criteria establishes that players who switch between DETGs and traditional slot machines may become eligible for Mystery Jackpot participation. The system recognizes and rewards players who engage with multiple game types, creating a unique cross-platform gaming experience that encourages exploration of the casino's diverse offerings.

Implementation may require a sophisticated, integrated player tracking system that may monitor activity across both electronic table games and slot machines. Each gaming device, whether a DETG or a slot machine, is connected to a central server. The server tracks the player's gaming activities, recording time spent and wagers made on each type of game.

The criteria may be customized to may require specific patterns of play. For example, a player may need to play a minimum of 30 minutes on a DETG and 30 minutes on a slot machine within a 24-hour period to qualify for the Mystery Jackpot. Alternatively, the system may require a certain number of wagers or a minimum total bet amount across both platforms.

### Benefits to Players:

1. Encourages exploration of different game types
2. Provides a more varied and exciting gaming experience
3. Offers additional ways to qualify for significant jackpots
4. Rewards versatility in gaming preferences

### Benefits to Casinos:

1. Promotes utilization of all gaming offerings
2. Increases player engagement across multiple platforms
3. Provides valuable data on cross-platform player behavior
4. Potentially increases overall time spent gaming and total wagers
5. Differentiates the casino by offering a unique, integrated gaming experience

Example Walk-through Scenario: Tom enters the casino and decides to start his evening at a DETG offering electronic roulette. He inserts his player card and is greeted with a message: “Welcome back, Tom! Play both table games and slots today for a chance at our Hybrid Gaming Mystery Jackpot!”

Intrigued, Tom begins playing roulette. After about 45 minutes, he receives a notification: “Great job, Tom! You've completed the table game portion of your Hybrid Gaming Challenge. Try some slot play to qualify for the Mystery Jackpot!”

Excited by the prospect of the jackpot, Tom decides to explore the slot machine area. He approaches a slot machine and inserts his player card. The machine recognizes him and displays a message: “Welcome to slots, Tom! You're on your way to Mystery Jackpot eligibility. Play for at least 30 minutes to qualify !”

As Tom plays the slot machine, a timer on the screen counts down his progress towards eligibility. When he reaches the 30-minute mark, celebratory graphics appear: “Congratulations, Tom! You've qualified for the Hybrid Gaming Mystery Jackpot! Every spin now has a chance to trigger a jackpot win!”

Energized by his new eligibility, Tom continues to play slots for a while longer. He then decides to return to the DETG area, curious if his eligibility carries over. Upon inserting his card at an electronic blackjack table, he's pleased to see a notification confirming his continued Mystery Jackpot eligibility.

Throughout the rest of his visit, Tom switches between slots and DETGs several times, enjoying the variety and maintaining his Mystery Jackpot eligibility. He notices that each time he switches game types, he receives a message encouraging his diverse play and reminding him of his jackpot eligibility.

Near the end of his session, while playing at a DETG, Tom's screen suddenly erupts in a dazzling display of lights and sounds. A message appears: “Congratulations, Tom! Your hybrid gaming adventure has paid off. You've won a $5,000 Mystery Jackpot!”

Thrilled with his win and the exciting gaming experience, Tom leaves the casino feeling rewarded for his willingness to try different games. He's already planning his next visit, eager to explore more game combinations and potentially win another Hybrid Gaming Mystery Jackpot.

### Example System Procedural Flow:

1. Player Identification and Profile Retrieval:
   Player inserts card or enters credentials at any gaming device
   Device sends player ID to central server
   Server authenticates player and loads profile with gaming history
2. Hybrid Criteria Initialization:
   Server checks if player has active hybrid gaming session
   If not, server initializes new hybrid gaming challenge
   Eligibility criteria (time, wagers, etc.) are set and sent to device
3. Game Type Tracking:
   Server categorizes current game (DETG or slot)
   Play time and wager amounts are continuously logged
   Data is used to update progress towards hybrid criteria
4. Real-time Progress Monitoring:
   Server constantly evaluates player's progress across game types
   Updates are sent to current gaming device for display to player
   Notifications are triggered at notable milestones (e.g., halfway to goal)
5. Cross-Platform Synchronization:
   When player switches game types, new device queries server
   Server transfers current hybrid challenge status to new device
   Consistent experience maintained across all gaming platforms
6. Eligibility Achievement:
   Server detects when hybrid criteria are met
   Eligibility flag is set in player's profile
   Confirmation message sent to current gaming device
7. Mystery Jackpot Activation:
   Upon eligibility, server activates jackpot opportunity for player
   Random Number Generator (RNG) begins monitoring player's game outcomes
   Jackpot win parameters are loaded based on current game type
8. Continuous Eligibility Monitoring:
   Server tracks time since eligibility achieved
   If eligibility period expires, server may prompt re-qualification
   Player is notified of any changes in eligibility status
9. Jackpot Trigger and Award:
   If RNG determines a jackpot win, server immediately notifies device
   Gaming device displays win animation and amount
   Server updates financial systems and jackpot pool
10. Session Analysis and Reporting:
   Upon player card removal, server compiles session data
   Analysis of hybrid gaming patterns is generated
   Data is used to refine hybrid criteria and jackpot strategies
11. Player Profile Update:
   Server updates player's profile with hybrid gaming history
   New personalized hybrid challenges may be generated for next visit
   Marketing team is notified of player's cross-platform engagement
12. System-wide Optimization:
   Casino management receives reports on hybrid gaming participation
   Data informs decisions on game placement and promotional strategies
   Hybrid criteria are periodically adjusted based on overall player behavior Noteworthy Aspects and Features: This eligibility criteria introduces several innovative elements to Mystery

### Jackpot Implementations:

1. Cross-Platform Integration: By bridging the gap between table games and slots, this system creates a unique, cohesive gaming experience that was previously impossible.
2. Dynamic Player Journeys: The system encourages players to create their own diverse gaming experiences, potentially discovering new favorite games in the process.
3. Adaptive Challenge System: Hybrid gaming criteria may be tailored to individual player preferences and skill levels, ensuring optimal engagement for all player types.
4. Real-time Progress Tracking: The continuous monitoring and feedback on hybrid gaming progress adds an element of gamification to the casino experience.
5. Flexible Eligibility Parameters: The ability to adjust criteria based on time played, wagers made, or other factors allows for precise tuning of the promotion.
6. Data-Rich Player Profiles: By tracking cross-platform play, the system generates comprehensive player profiles that may inform personalized marketing and game development.
7. Increased Floor Traffic: The hybrid system naturally encourages players to move around the casino floor, potentially increasing overall energy and engagement.
8. Novel Marketing Opportunities: The concept of hybrid gaming opens up new avenues for promotions and events that span multiple game types.

### Eligibility Criteria 47—Cross-Platform Play

Description and Implementation: This eligibility criteria establishes that players who engage with the casino's online or mobile platforms, in addition to playing at physical DETGs, may become eligible for Mystery Jackpot participation. The system recognizes and rewards players for their engagement across multiple gaming channels, creating a seamless experience between online and land-based play.

Implementation may require a sophisticated, integrated player account system that may track activity across online, mobile, and land-based platforms. Each platform is connected to a central server that maintains a unified player profile. The system tracks various engagement metrics such as login frequency, time spent playing, wagers made, and game types accessed across all platforms.

The criteria may be customized to may require specific patterns of cross-platform engagement. For example, a player may need to log into the mobile app at least once, place a minimum number of bets online, and play at a physical DETG within a 7-day period to qualify for the Mystery Jackpot. Alternatively, the system may use a points-based approach, where different activities on each platform contribute towards a total score that determines jackpot eligibility.

### Benefits to Players:

1. Rewards loyalty across all gaming channels
2. Provides a cohesive gaming experience regardless of platform
3. Offers additional ways to qualify for significant jackpots
4. Encourages exploration of different gaming options

### Benefits to Casinos:

1. Promotes utilization of all gaming channels
2. Increases player engagement and retention
3. Provides valuable data on cross-platform player behavior
4. Potentially increases overall time spent gaming and total wagers
5. Strengthens the connection between online and land-based offerings

Example Walk-through Scenario: Lisa is a regular at Golden Sands Casino and enjoys playing both online and at the physical casino. She receives an email about a new Cross-Platform Mystery Jackpot promotion. To qualify, she needs to complete three tasks within a week: log into the mobile app daily, place at least 50 bets on the online platform, and play for 1 hour at a physical DETG.

Excited by the challenge, Lisa begins by downloading the casino's mobile app. She sets a daily reminder to log in, which helps her complete the first task easily.

Next, she visits the casino's online platform and starts playing her favorite slots game. A progress bar at the top of the screen shows her advancement towards the 50-bet goal. After a few sessions spread over several days, she completes this requirement.

On Friday night, Lisa visits the physical casino. She approaches a DETG and inserts her player card. The screen lights up with a welcome message: “Great to see you, Lisa! You've already completed two parts of your Cross-Platform Challenge. Play for 1 hour here to qualify for the Mystery Jackpot!”

As Lisa plays electronic blackjack, a timer on the screen counts down her progress. When she reaches the 1-hour mark, the screen erupts in celebration: “Congratulations, Lisa! You've completed the Cross-Platform Challenge and are now eligible for the Mystery Jackpot!”

For the rest of her session, Lisa plays with the added excitement of potential jackpot wins. She notices that her online activity has unlocked special bonuses at the DETG, like a 5% boost to certain payouts.

Before leaving, Lisa checks her mobile app and sees that her Mystery Jackpot eligibility is displayed there too. She's informed that she may maintain her eligibility by continuing to engage across platforms, with a minimal activity requirement on each.

Over the next few weeks, Lisa finds herself more engaged with all aspects of Golden Sands' offerings. She checks the app daily, plays online a few times a week, and visits the physical casino more frequently, always excited by the prospect of hitting the Mystery Jackpot while enjoying her cross-platform gaming experience.

### Example System Procedural Flow:

1. Cross-Platform Challenge Setup:
   Casino management defines challenge criteria in central system
   System generates personalized challenges for each eligible player
   Challenge details are pushed to all platforms (online, mobile, DETG)
2. Player Notification:
   Player receives email/SMS about the Cross-Platform Challenge
   Challenge is prominently displayed upon login on any platform
3. Mobile App Engagement:
   Player logs into mobile app
   App sends login data to central server
   Server updates player's challenge progress
4. Online Platform Activity:
   Player accesses online casino and places bets
   Online platform tracks number of bets and sends data to central server
   Server updates challenge progress in real-time
5. Physical Casino Visit:
   Player inserts card at DETG
   DETG queries central server for player's current challenge status
   Server sends challenge details and progress to DETG
6. Real-time Progress Tracking:
   DETG monitors player's time spent gaming
   Updates are sent to central server periodically
   Server recalculates overall challenge progress
7. Eligibility Achievement:
   Central server detects completion of all challenge components
   Eligibility flag is set in player's unified profile
   Confirmation message sent to current gaming platform (DETG)
8. Cross-Platform Synchronization:
   Eligibility status is synced across all platforms
   Player may view updated status on mobile app and online platform
9. Mystery Jackpot Activation:
   Server activates jackpot opportunity for eligible player
   Random Number Generator (RNG) begins monitoring game outcomes
   Jackpot win parameters are loaded based on current game type
10. Continuous Engagement Monitoring:
   Server tracks ongoing cross-platform activity
   If engagement drops, server may issue re-engagement prompts
   New challenges are generated to maintain long-term participation
11. Jackpot Trigger and Award:
   If RNG determines a jackpot win, server immediately notifies current platform
   Win animation and amount are displayed to player
   Server updates financial systems and jackpot pool
12. Data Analysis and Optimization:
   System compiles comprehensive cross-platform engagement data
   Analysis informs future challenge designs and marketing strategies
   Casino management receives reports on the effectiveness of cross-platform initiatives

Noteworthy Aspects and Features: This eligibility criteria introduces several innovative elements to Mystery Jackpot implementations:
1. Omni-Channel Integration: By connecting online, mobile, and land-based play, this system creates a truly seamless gaming experience.
2. Personalized Cross-Platform Challenges: The ability to create custom challenges based on individual player preferences and behaviors ensures high engagement across all platforms.
3. Real-Time Synchronization: The instant updating of progress and eligibility status across all platforms keeps players informed and engaged regardless of how they choose to play.
4. Flexible Engagement Metrics: By considering various types of activity (logins, bets placed, time spent), the system may cater to different player styles and preferences.
5. Enhanced Data Collection: Tracking player behavior across multiple platforms provides a more complete picture of player preferences and habits.
6. Increased Brand Loyalty: By rewarding engagement across all of a casino's offerings, the system encourages players to stay within the casino's ecosystem for all their gaming needs.
7. Novel Marketing Opportunities: The cross-platform nature of the system opens up new avenues for targeted promotions and personalized offers.
8. Extended Player Lifetime Value: By engaging players across multiple touchpoints, the system has the potential to significantly increase player retention and lifetime value.

### Eligibility Criteria 48—Progressive Level Participation

Description and Implementation: Progressive Level Participation is an innovative eligibility criteria for Mystery Jackpot awards in live Dealer-controlled Electronic Table Games systems (DETGs) that rewards players for consistent and prolonged engagement. This system implements a tiered structure where players accumulate experience points (XP) through their gameplay, gradually advancing through different levels. Each level achieved unlocks new jackpot eligibility tiers, offering players increasing chances to win larger Mystery Jackpots.

The implementation involves integrating an XP tracking system within the DETG software. Players earn XP based on various factors such as time played, wagers made, games won, and special in-game achievements. The XP accumulation is continuous across multiple sessions, encouraging players to return to the DETGs. As players reach new levels, they are notified via on-screen alerts and potentially through linked mobile apps or emails. The system may include a visual representation of the player's progress, such as a progress bar or level indicator, displayed on the DETG screen.

Each level corresponds to a specific jackpot tier, with higher levels offering access to more substantial jackpots. For instance, Level 1 may offer eligibility for a $1,000 Mystery Jackpot, while Level 10 may provide a chance at a $100,000 jackpot. This progressive structure ensures that all players have a chance to win, while also incentivizing continued play and loyalty.

### Benefits to Players:

1. Continuous rewards for consistent play
2. Sense of progression and achievement
3. Access to larger jackpots as they level up
4. Increased excitement and engagement with each level gained
5. Recognition for loyalty and frequent play

### Benefits to Casinos:

1. Encourages repeat visits and longer play sessions
2. Increases player retention and loyalty
3. Provides valuable data on player behavior and preferences
4. Creates a competitive environment, potentially increasing overall play
5. Allows for targeted marketing based on player levels

Example Walk-through Scenario: Meet Sarah, a regular visitor to Casino Royale. On her first visit to the DETG area, she creates a player account and begins playing baccarat. As she plays, she notices an XP bar filling up on her screen. After an hour of play, she reaches Level 1, and a notification pops up informing her that she's now eligible for the $1,000 Mystery Jackpot.

Excited by this new development, Sarah continues to play. Over the next few weeks, she visits the casino several times, always choosing the DETGs. Each time she plays, her XP increases, and she watches as she progresses through the levels. By her fifth visit, she's reached Level 5, which makes her eligible for a $10,000 Mystery Jackpot.

During one session, while Sarah is playing at Level 5, the Mystery Jackpot is triggered. Although she doesn't win this time, she's thrilled to have been in the running for such a substantial prize. This motivates her to play more frequently, aiming to reach higher levels.

After three months of regular play, Sarah achieves Level 10. She receives a congratulatory message on the DETG screen, informing her that she's now eligible for the highest tier $100,000 Mystery Jackpot. The casino also sends her an email with a special bonus offer to celebrate her achievement.

On her next visit, Sarah sits down at a DETG, feeling a sense of accomplishment as she sees her Level 10 status displayed. As she plays, she knows that each hand not only brings the possibility of winning the game but also the chance of triggering the top-tier Mystery Jackpot. This dual layer of excitement keeps her engaged for hours.

Throughout her journey from Level 1 to Level 10, Sarah has become increasingly loyal to Casino Royale, particularly its DETG offerings. The progressive level system has transformed her from a casual player into a dedicated enthusiast, eagerly anticipating each visit and the potential for big wins.

### Example System Procedural Flow:

1. Player Identification:
   Player inserts loyalty card or enters credentials on DETG
   DETG sends player ID to central server
   Server retrieves player's current level and XP
2. Session Initiation:
   DETG displays player's current level and XP on screen
   Server determines jackpot eligibility based on player's level
   DETG updates Mystery Jackpot display with eligible amount
3. XP Accumulation:
   For each game played:
      DETG calculates XP earned based on wager amount, game outcome, and any special achievements
      XP data sent to server in real-time
      Server updates player's total XP
4. Level Progression Checking:
   After each XP update, server checks if player has reached a new level
   If new level reached:
      Server updates player's level in database
      Sends notification to DETG
      DETG displays level-up animation and new jackpot eligibility
5. Mystery Jackpot Participation:
   For each game round:
      Server determines if Mystery Jackpot should trigger
      If triggered, server checks all active, eligible players
      Winner selected based on predetermined criteria
6. Jackpot Award Process:
   If player wins Mystery Jackpot:
      Server sends win notification to DETG
      DETG displays win animation and amount
      Server updates jackpot amount and player's balance
      Initiates payout process based on casino protocols
7. Session End and Data Update:
   When player cashes out:
      DETG sends final session data to server
      Server calculates total XP earned in session
      Updates player's lifetime XP and level if applicable
      Stores detailed session history for analysis
8. Ongoing Level Maintenance:
   Server runs periodic checks (e.g., daily) on all player accounts
   Applies any level degradation rules (if implemented)
   Updates player levels based on inactivity or other criteria
9. Reporting and Analysis:
   System generates reports on:
      Player progression rates
      Jackpot win frequency by level
      Player engagement metrics
   Data used for refining level requirements and jackpot structures

This procedural flow ensures a seamless, real-time experience for the player while maintaining accurate records and enabling dynamic jackpot eligibility based on the player's progressive level.

Noteworthy Aspects and Features: The Progressive Level Participation system for Mystery Jackpot eligibility in DETGs introduces several novel and unique features:
1. Continuous Progression: Unlike traditional systems where eligibility resets after each session, this system maintains player progress across multiple visits, fostering long-term engagement.
2. Multi-tiered Jackpot Structure: By linking jackpot sizes to player levels, the system creates a more personalized and motivating jackpot experience.
3. Real-time Level Updates: The instant recognition of level achievements during play adds an extra layer of excitement to the gaming experience.
4. Integrated XP System: By tying XP to various aspects of gameplay, the system encourages diverse play styles and strategies.
5. Data-driven Customization: The wealth of data generated allows for unprecedented insight into player behavior, enabling casinos to tailor their offerings and marketing strategies.
6. Cross-platform Potential: This system may easily extend beyond DETGs to include other casino games, creating a unified progression system throughout the casino.
7. Scalability: The level-based structure allows for easy addition of new tiers or adjustment of XP requirements, providing flexibility as the player base evolves.
8. Transparent Progression: Visual representations of progress foster a sense of achievement and motivate continued play, addressing the psychological aspects of gaming.

### Eligibility Criteria 49—Mystery Bonus Activation

Description and Implementation: Mystery Bonus Activation is an innovative eligibility criteria for Mystery Jackpot awards in live Dealer-controlled Electronic Table Games systems (DETGs) that adds an exciting layer of unpredictability to gameplay. This system randomly triggers special bonus features during regular gameplay, and upon unlocking these bonuses, players become eligible for Mystery Jackpot participation.

The implementation involves integrating a random number generator (RNG) within the DETG software that operates independently of the main game outcomes. At random intervals, the system activates a Mystery Bonus round, which may manifest as mini-games, multipliers, or special bets. These bonus rounds are designed to be quick and engaging, maintaining the pace of the main game while offering additional excitement.

When a Mystery Bonus is triggered, the player is presented with a choice or a quick challenge. Successfully completing the bonus not only provides immediate rewards but also unlocks eligibility for the Mystery Jackpot for a set duration (e.g., the next 10 hands or 30 minutes of play). This creates a dual layer of anticipation—players are excited about the immediate bonus and the potential for a larger jackpot win.

The frequency and type of Mystery Bonuses may be adjusted based on factors such as time of day, player status, or overall casino activity, allowing for dynamic management of game excitement and jackpot eligibility.

### Benefits to Players:

1. Unexpected bursts of excitement during regular play
2. Additional chances to win beyond the main game
3. Skill-based elements in bonus rounds add engagement
4. Temporary jackpot eligibility creates a sense of urgency and thrill
5. Variety in gameplay keeps the experience fresh and engaging

### Benefits to Casinos:

1. Increases player engagement and time on device
2. Provides additional data points for player behavior analysis
3. Allows for flexible promotion implementation
4. Creates talking points and social sharing opportunities
5. Differentiates DETG offerings from traditional table games

Example Walk-through Scenario: Mike is playing blackjack at a DETG in Lucky Star Casino. He's been at the table for about an hour when suddenly, the screen flashes with a “Mystery Bonus Activated!” message. Excited, Mike watches as a wheel appears on his screen, divided into sections labeled with different bonus types.

The wheel spins and lands on “High Card Challenge.” Mike is presented with five face-down cards and told to pick one. He selects the middle card, and it's revealed to be a King of Hearts. The system announces that Mike has won the challenge, awarding him 50 bonus credits and, more importantly, activating his eligibility for the Mystery Jackpot for the next 15 minutes.

As Mike returns to his blackjack game, he notices a timer in the corner of his screen counting down his Mystery Jackpot eligibility. Each hand he plays now carries the added thrill of potentially triggering the big win. Other players at nearby DETGs notice Mike's excited play and the special indicator on his screen, creating a buzz around the gaming area.

Ten minutes into his eligibility period, another Mystery Bonus activates. This time, it's a “Quick Pick” challenge where Mike needs to choose between two mystery boxes. He selects the left box, revealing a 2× multiplier for his next hand and an extension of his Mystery Jackpot eligibility by five minutes.

With just two minutes left on his eligibility timer, the Mystery Jackpot suddenly triggers. The screen erupts in a celebration of lights and sounds, announcing that Mike has won a $5,000 jackpot. The other players cheer, and a casino attendant approaches to congratulate Mike and arrange for his payout.

As Mike's remarkable session comes to an end, he's already planning his next visit. The unexpected bonuses and jackpot win have transformed what would have been a routine gaming session into a memorable event. He shares his experience with friends at the casino, spreading excitement about the DETG's Mystery Bonus feature.

Over the next few days, Lucky Star Casino sees an uptick in DETG activity as word spreads about Mike's win and the exciting Mystery Bonus feature. Players are drawn to the tables, eager to experience their own moment of mystery and potential jackpot glory.

### Example System Procedural Flow:

1. Mystery Bonus Trigger Determination:
   DETG's RNG continuously runs in background
   System checks RNG output against predefined trigger values
   When trigger value is hit, Mystery Bonus activation is queued
2. Player Eligibility Check:
   System verifies player's current status (e.g., minimum bet requirements, play duration)
   If player is eligible, Mystery Bonus is activated
   If not eligible, activation is held for next eligible player
3. Mystery Bonus Presentation:
   DETG interrupts main game flow (after hand completion)
   Bonus game interface is displayed to player
   System provides instructions for bonus game participation
4. Bonus Game Execution:
   Player interacts with bonus game (e.g., making selections, playing mini-game)
   DETG processes player input
   Bonus game outcome is determined by separate RNG
5. Bonus Reward Calculation:
   Based on bonus game outcome, system calculates reward
   Reward may include credits, multipliers, or special features
   Mystery Jackpot eligibility duration is determined
6. Mystery Jackpot Eligibility Activation:
   System flags player account as jackpot-eligible
   Eligibility timer is initiated and displayed on DETG screen
   Jackpot eligibility status is communicated to central server
7. Continued Gameplay with Eligibility:
   Player resumes main game
   For each game round during eligibility period:
      System checks for Mystery Jackpot trigger
      If triggered, jackpot win process is initiated
8. Eligibility Period Management:
   System continuously monitors eligibility timer
   Additional bonuses may extend eligibility period
   When timer expires, eligibility flag is removed
9. Mystery Jackpot Award (if triggered):
   Central server confirms player's eligibility
   Jackpot amount is verified and locked
   Win animation and notification displayed on DETG
   Player's account is credited with jackpot amount
10. Post-Bonus/Jackpot Procedures:
   System logs all bonus activities and outcomes
   Player's bonus/jackpot history is updated
   Data is stored for analysis and reporting
11. Dynamic Adjustment:
   System analyzes bonus frequency and jackpot hits
   Adjusts trigger rates and eligibility durations as needed
   Updates bonus game types and rewards based on popularity
12. Reporting and Compliance:
   Generates detailed reports on bonus activations and jackpot awards
   Ensures all random events comply with gaming regulations
   Provides audit trail for each Mystery Bonus and Jackpot event

This procedural flow ensures a seamless integration of the Mystery Bonus feature into the DETG gameplay, maintaining game integrity while adding an exciting new dimension to the player experience.

Noteworthy Aspects and Features: The Mystery Bonus Activation system for Mystery Jackpot eligibility in DETGs introduces several novel and unique features:
1. Dual-Layer Random Events: By combining random bonus triggers with jackpot eligibility, it creates a multi-tiered excitement structure.
2. Time-Limited Jackpot Eligibility: The temporary nature of eligibility adds urgency and heightened engagement to regular gameplay.
3. Skill-Based Elements: Incorporating player choices in bonus rounds adds a layer of perceived control and engagement.
4. Dynamic Difficulty Adjustment: The system may adjust bonus frequency and difficulty based on player skill levels and casino preferences.
5. Seamless Integration: Mystery Bonuses are designed to complement rather than interrupt the main game flow.
6. Social Catalyst: The visible nature of bonus rounds may create a spectator effect, drawing attention to DETGs.
7. Flexible Reward Structure: The system may easily incorporate various types of rewards beyond just jackpot eligibility.
8. Data-Rich Player Interactions: Each bonus round provides valuable data on player preferences and decision-making.
9. Regulatory Compliance: The system is designed to maintain transparency and fairness, adhering to gaming regulations.
10. Cross-Promotional Potential: Mystery Bonuses may be themed to promote casino events or new game offerings.

### Eligibility Criteria 50˜Game-Specific Hand History

Description and Implementation: Game-Specific Hand History is an innovative eligibility criteria for Mystery Jackpot awards in live Dealer-controlled Electronic Table Games systems (DETGs) that rewards players for achieving specific milestone hands based on their historical play. This system tracks players' hands across multiple sessions and games, recognizing and celebrating significant achievements in their gaming journey.

The implementation involves a sophisticated database system integrated with the DETGs that records every hand played by each identified player. The system categorizes hands based on game type (e.g., blackjack, baccarat, poker) and tracks the frequency and significance of specific hand combinations. Milestones are set for each game type, such as the 10th royal flush in poker, the 50th blackjack, or the 100th natural 9 in baccarat.

When a player achieves a milestone hand, the system immediately recognizes this achievement, triggering a celebration on the DETG screen and unlocking Mystery Jackpot eligibility. The eligibility period may vary based on the significance of the milestone, ranging from immediate entry into a jackpot draw to extended eligibility for multiple gaming sessions.

This system not only adds an extra layer of excitement to each hand played but also creates a sense of progression and accomplishment over time, encouraging player loyalty and repeated visits to the casino's DETG area.

### Benefits to Players:

1. Long-term recognition of gaming achievements
2. Additional excitement with each hand played
3. Sense of progression and mastery in their favorite games
4. Unexpected rewards for consistent play
5. Personalized gaming experience based on individual history

### Benefits to Casinos:

1. Encourages player loyalty and repeat visits
2. Provides rich data on player preferences and skill levels
3. Creates opportunities for targeted marketing and promotions
4. Differentiates DETG offerings from traditional table games
5. Increases time on device as players aim for milestones

Example Walk-through Scenario: Linda has been a regular at the Stardust Casino's DETG poker tables for several months. She always uses her player card, allowing the system to track her hands. One evening, she sits down at her favorite Texas Hold'em DETG, unaware that she's about to hit a significant milestone.

As Linda plays, a notification appears on her screen: “Approaching Milestone: 2 more flushes to your 50th!” Excited by this information, Linda continues to play with renewed enthusiasm. Two hours into her session, she's dealt a hand that completes her 50th flush.

Suddenly, the DETG screen erupts in a celebratory animation. “Congratulations! You've achieved your 50th flush!” the screen announces. “You've unlocked Mystery Jackpot eligibility for your next 20 hands!”

Linda is thrilled. She knows that each of her next 20 hands now carries the potential for a substantial jackpot win. As she plays, a small jackpot eligibility counter in the corner of her screen ticks down with each hand.

On her 15th eligible hand, the Mystery Jackpot suddenly triggers. The screen flashes with excitement as Linda realizes she's won a $2,000 jackpot. Other players at nearby DETGs notice the commotion, and a small crowd gathers to congratulate her.

As a casino attendant approaches to verify the win, Linda's screen displays a summary of her achievement: “50th Flush Milestone Reached! Reward: Mystery Jackpot Eligibility. Result: $2,000 Jackpot Win!” The attendant explains that this information will also be available in Linda's player account history.

Energized by her win, Linda continues to play, now curious about other milestones she may be approaching. She checks her player statistics and sees she's nearing her 100th full house. This knowledge adds an extra layer of anticipation to each hand she plays.

As Linda leaves the casino that night, she's already planning her next visit. The milestone system has transformed her gaming experience, making each session feel like part of a larger, more rewarding journey. She tells her friends about the experience, eager to share the excitement of the Game-Specific Hand History feature.

In the weeks that follow, the Stardust Casino notices an uptick in DETG activity, particularly among players who have been close to achieving milestones. The Game-Specific Hand History system has successfully created a new level of engagement and loyalty among their DETG players.

### Example System Procedural Flow:

1. Player Identification and History Retrieval:
   Player inserts loyalty card or logs in to DETG
   System sends player ID to central server
   Server retrieves player's comprehensive hand history and milestone progress
2. Session Initiation:
   DETG displays player's current progress towards nearest milestones
   System sets up tracking for current session
3. Hand Tracking and Categorization:
   For each hand played:
DETG sends hand details to central server
Server categorizes hand based on game type and outcome
Hand is added to player's historical record
System updates progress towards relevant milestones
4. Milestone Check:
   After each hand, system checks if a milestone has been reached
   If milestone reached:
      Server flags player account for celebration and reward
      Sends notification to DETG
5. Milestone Celebration and Reward:
   DETG displays celebration animation
   System determines reward (e.g., Mystery Jackpot eligibility duration)
   Player is notified of their reward and eligibility status
6. Mystery Jackpot Eligibility Activation:
   System activates jackpot eligibility flag on player's account
   Sets eligibility timer based on milestone significance
   DETG displays eligibility status and countdown
7. Gameplay with Jackpot Eligibility:
   For each eligible hand:
      System checks for Mystery Jackpot trigger
      If triggered, initiates jackpot win process
   Eligibility counter decreases with each hand played
8. Jackpot Award Process (if triggered):
   Server verifies player's eligibility status
   Locks in jackpot amount
   Sends win notification to DETG
   Initiates payout process per casino protocols
9. Continuous Milestone Monitoring:
   System continuously updates player's progress towards next milestones
   Provides periodic notifications of approaching milestones
10. Session End Processing:
   System finalizes hand count for the session
   Updates player's lifetime statistics
   Stores detailed session history
11. Data Analysis and Reporting:
   System generates reports on:
      Milestone achievement rates
      Correlation between milestones and player engagement
      Jackpot win frequency related to milestones
   Data used to refine milestone definitions and rewards
12. Dynamic Adjustment:
   Based on analysis, system may adjust:
      Milestone definitions
      Reward structures
      Eligibility durations
13. Marketing Integration:
   System flags accounts nearing significant milestones
   Generates targeted marketing campaigns to encourage milestone completion
14. Compliance and Auditing:
   Maintains detailed logs of all milestone achievements and rewards
   Provides audit trail for regulatory compliance
   Ensures fairness in milestone tracking and reward distribution

This procedural flow ensures a comprehensive, real-time tracking of player achievements, seamlessly integrating milestone celebrations and Mystery Jackpot eligibility into the DETG gaming experience while maintaining system integrity and compliance.

Noteworthy Aspects and Features: The Game-Specific Hand History system for Mystery Jackpot eligibility in DETGs introduces several novel and unique features:
1. Long-Term Player Engagement: By tracking hands across multiple sessions, it creates a continuous gaming narrative for each player.
2. Multi-Game Integration: The system may track achievements across various game types, encouraging players to explore different DETGs.
3. Personalized Gaming Experience: Each player's journey towards milestones is unique, creating a highly individualized experience.
4. Dynamic Milestone System: Casinos may adjust milestone definitions and rewards based on player behavior and business objectives.
5. Skill Recognition: The system acknowledges player skill and consistency, not just luck, in determining jackpot eligibility.
6. Data-Rich Player Profiles: Comprehensive hand histories provide unprecedented insights into player behavior and preferences.
7. Cross-Promotional Opportunities: Milestone achievements may be linked to other casino offerings or events.
8. Scalable Reward Structure: The system may easily incorporate various types of rewards beyond just jackpot eligibility.
9. Social Gaming Elements: Achievements may be designed to encourage social interaction or friendly competition among players.
10. Regulatory Compliance: The detailed tracking system ensures transparency and fairness in jackpot eligibility determination.

This system not only enhances the gaming experience but also provides casinos with a powerful tool for player retention and data-driven decision making.

### Mystery Jackpot Triggering Criteria Example Embodiments

### Mystery Jackpot Triggering Criteria #1—Cumulative Wager Threshold

Description and Implementation: This Mystery Jackpot triggering criteria is based on reaching a cumulative wager threshold across all Electronic Table Game Terminals (ETGTs) in the casino. The system tracks the total amount wagered on all connected ETGTs in real-time. When the cumulative wagers reach a predetermined threshold (e.g., $100,000), the Mystery Jackpot is triggered.

The implementation involves a central tracking system that monitors wagers placed at each ETGT. Every time a player makes a bet, the wager amount is transmitted to the central system and added to the cumulative total. The system continuously compares this total against the preset threshold. To add excitement, the current cumulative wager amount may be displayed on screens at ETGTs or on overhead displays, allowing players to see how close the jackpot is to triggering.

The threshold may be set to a fixed amount or may be randomly generated within a range for each jackpot cycle. This keeps players guessing and maintains engagement. The system may also incorporate a “must-hit-by” amount to ensure the jackpot is awarded before reaching a certain maximum.

### Benefits to Players:

Creates anticipation as players may see the cumulative wager amount approaching the threshold
Provides an additional chance to win beyond the base game
Encourages longer play sessions as players try to contribute to reaching the threshold
Offers potential for larger jackpots compared to individual game payouts

### Benefits to Casinos:

Increases player engagement and time on device
Encourages higher betting volumes as players try to trigger the jackpot
Creates a sense of community among players working towards a common goal
Allows for flexible jackpot sizes based on casino preferences and player activity
Provides promotional opportunities around jackpot events

Example Walk-through Scenario: John enters the casino and approaches an Electronic Table Game Terminal for blackjack. He notices the overhead display showing a cumulative wager total of $97,500 towards a $100,000 Mystery Jackpot threshold. Excited by the possibility of triggering the jackpot, John sits down and inserts his player card.

As John begins playing, he places a $25 bet. The ETGT transmits this wager information to the central system, which adds it to the cumulative total. The overhead display updates to $97,525. John continues to play, placing several more bets. With each wager, he watches the total creep closer to the threshold.

After about 15 minutes of play, the cumulative total reaches $99,950. The excitement in the area is palpable as players realize the jackpot is close to triggering. John places another $25 bet, bringing the total to $99,975. He holds his breath as he waits to see if someone else will place the bet that pushes it over the edge.

Suddenly, at a nearby roulette ETGT, a player places a $50 bet. The system registers this wager, pushing the cumulative total to $100,025 and triggering the Mystery Jackpot. Lights and sounds activate across all ETGTs in the area, alerting players to the jackpot event.

The central system randomly selects one of the active ETGTs as the jackpot winner. To John's amazement, his terminal is chosen! The screen on his ETGT lights up, announcing he's won the $50,000 Mystery Jackpot. Casino staff approach to verify the win and arrange for payment.

As John celebrates his unexpected windfall, the cumulative wager total on the overhead display resets to $0, and players eagerly begin placing bets to work towards the next Mystery Jackpot threshold.

### Example System Procedural Flow:

1. System Initialization:
   Central server initializes the cumulative wager tracker
   Jackpot threshold is set (e.g., $100,000)
   ETGTs are connected to the central server
2. Player Interaction:
   Player inserts card or buys in at an ETGT
   ETGT registers player and communicates with player tracking system
3. Wager Placement:
   Player places a bet on the ETGT
   ETGT sends wager amount and player ID to central server
4. Central Server Processing:
   Server receives wager information
   Wager amount is added to the cumulative total
   Server updates all connected displays with new total
5. Threshold Check:
   After each wager, server compares cumulative total to threshold
   If threshold not met, system continues monitoring
6. Jackpot Trigger:
   When a wager causes the cumulative total to meet or exceed the threshold
   Server flags the jackpot as triggered
7. Winner Selection:
   Server generates a random number
   Number is used to select a winning ETGT from all active terminals
8. Notification:
   Server sends jackpot win signal to the selected ETGT
   Signals sent to all ETGTs to display jackpot won message
   Overhead displays updated to show jackpot won
9. Winner Verification:
   Winning ETGT locks and signals floor staff
   Staff verifies win using backend system
10. Payout Process:
   Jackpot amount credited to winner's account or hand-paid based on casino protocol
   Tax forms generated if required
11. System Reset:
   Cumulative wager total reset to 0
   New jackpot threshold set (if variable)
   All ETGTs and displays updated to reflect new jackpot cycle
12. Logging and Reporting:
   Details of win logged in central database
   Reports generated for accounting and regulatory compliance

Noteworthy Aspects and Features: This Mystery Jackpot triggering criteria offers several novel and unique features compared to traditional jackpot systems:
1. Cross-Game Integration: Unlike game-specific jackpots, this system spans multiple game types on ETGTs, creating a unified jackpot experience.
2. Real-Time Tracking: The system provides immediate updates on wager totals, enhancing player engagement and excitement.
3. Transparent Progress: Displaying the cumulative wager total allows players to see their direct impact on jackpot progress.
4. Flexible Threshold Setting: Casinos may adjust the threshold based on desired jackpot frequency and size, allowing for dynamic management of the jackpot feature.
5. Community Aspect: Players collectively contribute to the jackpot, fostering a sense of shared experience and camaraderie.
6. Automated Winner Selection: The system fairly and randomly selects a winner from all active players, eliminating human intervention.
7. Scalability: This system may easily scale to accommodate additional ETGTs or even multiple casino properties.
8. Data-Driven Insights: The wager tracking provides valuable data on player behavior and game popularity, informing casino management decisions.

### Mystery Jackpot Triggering Criteria #2—Random Timer-Based Trigger

Description and Implementation: This Mystery Jackpot triggering criteria utilizes a randomized time-based system to determine when a jackpot is awarded. The system randomly selects specific time periods (e.g., every 17 minutes) during which a Mystery Jackpot may be triggered. This implementation adds an element of unpredictability and excitement to the gaming experience.

The central server uses a random number generator to determine the next jackpot trigger time within predefined parameters. For example, it may select a time between 15 and 20 minutes from the last jackpot. This time is kept secret from players. When the selected time is reached, the system enters a “hot mode” where it randomly selects an active Electronic Table Game Terminal (ETGT) to receive the jackpot.

To ensure fairness, the system only considers ETGTs with active play during the “hot mode” period. This encourages continuous play and engagement. The exact moment of the jackpot award within the “hot mode” may also be randomized to add further unpredictability.

### Benefits to Players:

Adds excitement and anticipation to every gaming session
Provides equal opportunity to win regardless of bet size or game type
Encourages players to maintain active play to be eligible for the jackpot
Creates unexpected moments of celebration and excitement on the gaming floor

### Benefits to Casinos:

Increases player engagement and time on device
Flexible system allows for adjustable frequency and size of jackpots
Creates regular moments of excitement that may attract new players
Provides opportunities for marketing and promotions around jackpot events

Example Walk-through Scenario: Sarah enters the casino at 7:30 PM and starts playing at a baccarat ETGT. Unknown to her, the system has randomly selected 7:47 PM as the next potential jackpot time.

As Sarah plays, she notices occasional announcements reminding players that a Mystery Jackpot may happen at any time. This keeps her engaged and excited as she continues to play.

At 7:47 PM, the system enters its “hot mode”. Sarah is still playing, along with dozens of other players at various ETGTs across the casino floor. The system randomly selects an active ETGT to receive the jackpot.

At 7:47:35 PM, lights and sounds suddenly activate across all ETGTs. The system has selected Sarah's terminal as the winner. Her screen lights up with a celebratory animation, announcing she's won a $10,000 Mystery Jackpot.

Casino staff quickly approach to verify the win and arrange for payment. As Sarah celebrates, other players congratulate her while eagerly continuing their own play, knowing another Mystery Jackpot may be just minutes away.

### Example System Procedural Flow:

1. System Initialization:
   Central server initializes the random timer system
   Parameters set for minimum and maximum time between jackpots
2. Random Time Selection:
   System generates a random time for the next jackpot trigger
   Timer starts counting down to the selected time
3. Player Activity Monitoring:
   System continuously monitors all active ETGTs
   Player buy-ins, wagers, and cash-outs are tracked
4. Jackpot Trigger Time Reached:
   System enters “hot mode” when the selected time is reached
   A short window (e.g., 30 seconds) is initiated for winner selection
5. Active ETGT Identification:
   System compiles a list of all ETGTs with active play during “hot mode”
6. Winner Selection:
   Random number generator selects a winning ETGT from the active list
   Exact moment of selection within “hot mode” window is also randomized
7. Jackpot Notification:
   Winning ETGT is notified of the jackpot win
   All ETGTs display jackpot won message
   Overhead displays and sounds activate to announce the win
8. Winner Verification:
   Winning ETGT locks and signals floor staff
   Staff verifies win using backend system
9. Payout Process:
   Jackpot amount credited to winner's account or hand-paid based on casino protocol
   Tax forms generated if required
10. System Reset:
   New random time selected for the next jackpot
   Timer restarted
   All ETGTs updated to reflect new jackpot cycle
11. Logging and Reporting:
   Details of win logged in central database
   Reports generated for accounting and regulatory compliance

Noteworthy Aspects and Features:
Unpredictability: The random timer creates an element of surprise that keeps players engaged.
Fairness: All active players have an equal chance of winning, regardless of bet size or game type.
Flexibility: Casinos may adjust the frequency and size of jackpots by modifying the time parameters.
Cross-Game Integration: The system works across all types of ETGTs, creating a unified jackpot experience.
Promotion Potential: The regular jackpot events create opportunities for marketing and player attraction.
Continuous Engagement: The possibility of a jackpot at any time encourages longer play sessions.
Scalability: The system may easily accommodate additional ETGTs or even multiple casino properties.
Data Collection: Provides valuable insights into player behavior and peak activity times.

### Mystery Jackpot Triggering Criteria #3—Simultaneous Player Bet Match

Description and Implementation: This Mystery Jackpot triggering criteria is based on the occurrence of simultaneous identical wagers placed by multiple players on different Electronic Table Game Terminals (ETGTs). The system monitors all bets placed across the casino floor in real-time, looking for instances where a predetermined number of players place the exact same wager amount at the same time.

The implementation may require a sophisticated central monitoring system that may process bet information from all ETGTs instantaneously. When a bet is placed, the system records the amount and timestamp. It then compares this information against other bets placed within a very narrow time window (e.g., within 1 second) to identify matches.

The casino may set parameters such as the number of matching bets required (e.g., 3, 5, or 10) and the time window for considering bets simultaneous. These parameters may be adjusted based on the number of active ETGTs and desired jackpot frequency.

### Benefits to Players:

Creates a unique social aspect to individual game play
Provides an additional win opportunity beyond the base game
Encourages players to vary their bet amounts for a chance at triggering the jackpot
Adds an element of luck and coincidence to the gaming experience

### Benefits to Casinos:

Promotes higher betting volumes as players try different bet amounts
Creates a sense of community among players
Provides a novel jackpot mechanic that may differentiate the casino
Allows for flexible jackpot sizes based on the rarity of the trigger event

Example Walk-through Scenario: It's a busy Saturday night at the casino. Tom, Lisa, and Maria are playing at different ETGTs across the floor—Tom at a blackjack terminal, Lisa at roulette, and Maria at baccarat.

At 9:15:23 PM, Tom decides to place a $25 bet on his next blackjack hand. At almost the exact same moment, Lisa places a $25 bet on red at the roulette table. Simultaneously, Maria places a $25 player bet in baccarat.

The central system detects that three $25 bets were placed within its defined time window (in this case, 1 second). This triggers the Mystery Jackpot event. Lights and sounds activate across all ETGTs, announcing that a jackpot has been triggered.

The system then randomly selects one of the three players who placed the matching bets to receive the jackpot. In this case, Maria's terminal is chosen. Her screen lights up with a celebratory animation, announcing she's won a $5,000 Mystery Jackpot.

As casino staff approach Maria to verify her win, Tom and Lisa realize they were part of the triggering event. While they didn't win the main jackpot, the casino's system awards them each a smaller consolation prize of $500 for their part in activating the jackpot.

The event creates a buzz on the casino floor, with players excitedly discussing how close they were to being part of the jackpot trigger. Many players begin placing $25 bets, hoping to be part of the next coincidental match.

### Example System Procedural Flow:

1. System Initialization:
   Central server sets parameters for jackpot trigger (e.g., 3 matching bets within 1 second)
   All ETGTs connected to central monitoring system
2. Continuous Bet Monitoring:
   System monitors all bets placed on every ETGT in real-time
   Each bet amount and exact timestamp is recorded
3. Bet Comparison:
   For each new bet, system compares against other bets within the defined time window
   System counts the number of matching bet amounts
4. Trigger Evaluation:
   If the required number of matching bets is detected, jackpot is triggered
   System flags all ETGTs involved in the triggering event
5. Jackpot Activation:
   System sends signal to activate jackpot celebration across all ETGTs
   Overhead displays and sounds announce the jackpot event
6. Winner Selection:
   System randomly selects one ETGT from those involved in the trigger
   Winning ETGT is notified of the main jackpot win
7. Consolation Prizes:
   Other ETGTs involved in the trigger are awarded consolation prizes
   System credits consolation amounts to respective player accounts
8. Notification and Verification:
   Winning ETGT locks and signals floor staff
   Staff verifies main jackpot win and consolation prizes using backend system
9. Payout Process:
   Main jackpot and consolation prizes credited or hand-paid based on casino protocol
   Tax forms generated if required
10. System Reset:
   Jackpot amount reset for next trigger event
   All ETGTs updated to reflect new jackpot cycle
11. Logging and Reporting:
   Details of main win and consolation prizes logged in central database
   Reports generated for accounting and regulatory compliance

### Noteworthy Aspects and Features:

Social Interaction: This system creates a shared experience among players, even across different game types.
Multi-Winner Structure: The main jackpot winner and consolation prizes create multiple happy players per event.
Cross-Game Integration: The system works across all types of ETGTs, unifying the jackpot experience.
Bet Variation Encouragement: Players are motivated to try different bet amounts, potentially increasing overall betting volume.
Instant Feedback: Players involved in triggering the jackpot know immediately, even if they don't win the main prize.
Scalability: The trigger parameters may be easily adjusted based on the number of active ETGTs and desired jackpot frequency.
Marketing Potential: The unique triggering mechanism provides interesting stories for casino marketing.
Data Insights: The system provides valuable data on betting patterns and player behavior.

### Mystery Jackpot Triggering Criteria #4˜Special Card Combination

Description and Implementation: This Mystery Jackpot triggering criteria is based on the appearance of a specific combination of cards at any player's Electronic Table Game Terminal (ETGT). The system monitors the cards dealt in real-time across all card-based games on the casino floor, looking for predetermined special combinations that trigger the jackpot.

Implementation involves integrating with the card recognition technology in each ETGT. As cards are dealt, their values and suits are transmitted to the central system. The system compares each hand against a list of qualifying combinations (e.g., Royal Flush in poker, specific suited runs in blackjack). When a qualifying combination appears, the Mystery Jackpot is triggered.

The casino may define multiple qualifying combinations with different jackpot tiers. For example, a Royal Flush may trigger the highest tier jackpot, while a Straight Flush triggers a lower tier. This allows for a range of jackpot sizes and frequencies.

### Benefits to Players:

Adds extra excitement to every hand dealt
Provides an additional win opportunity beyond the base game
Creates memorable moments when rare card combinations appear
Encourages players to try different card games to experience various qualifying combinations

### Benefits to Casinos:

Increases player engagement across all card-based ETGTs
Provides flexibility in setting jackpot sizes and frequencies
Creates talking points and viral moments around rare card combinations
Encourages players to spend more time at card game ETGTs

Example Walk-through Scenario: Emily sits down at a poker ETGT and begins playing. She's aware of the Mystery Jackpot feature but focuses on her game. After several hands, Emily is dealt a Royal Flush in spades.

As soon as the last card is dealt, the ETGT recognizes the special combination. It immediately sends this information to the central system, which confirms it as a jackpot-triggering event.

Suddenly, lights and sounds activate across all ETGTs in the casino. Emily's screen erupts with a celebratory animation, announcing she's triggered the highest tier Mystery Jackpot worth $100,000.

Casino staff quickly approach to verify the winning hand and initiate the payout process. Other players gather around, amazed at seeing the rare Royal Flush that triggered the massive jackpot.

As Emily celebrates her win, the casino announces over the PA system that a Royal Flush Mystery Jackpot has been hit, creating a buzz throughout the gaming floor. Many players move to card game ETGTs, hoping to be the next to hit a special combination.

In the following days, the casino uses Emily's win in marketing materials, illustrating the huge prizes possible from their Mystery Jackpot system.

### Example System Procedural Flow:

1. System Initialization:
   Central server loads list of qualifying card combinations and associated jackpot tiers
   All card game ETGTs connected to central monitoring system
2. Continuous Hand Monitoring:
   As each card is dealt at an ETGT, its value and suit are transmitted to the central system
   System builds a representation of each player's hand in real-time
3. Combination Checking:
   After each card is added to a hand, system compares the current hand against the list of qualifying combinations
   System identifies if the hand matches any jackpot-triggering combination
4. Jackpot Trigger Evaluation:
   If a qualifying combination is detected, system determines the appropriate jackpot tier
   System flags the triggering ETGT and prepares to initiate jackpot sequence
5. Jackpot Activation:
   System sends signal to activate jackpot celebration across all ETGTs
   Overhead displays and sounds announce the specific combination that triggered the jackpot
6. Winner Notification:
   Triggering ETGT is notified of the jackpot win
   Player's screen displays win amount and celebratory animation
7. Verification Process:
   Winning ETGT locks and signals floor staff
   Staff visually verifies the winning card combination
   Backend system confirms the win and jackpot amount
8. Payout Process:
   Jackpot amount credited to winner's account or hand-paid based on casino protocol and amount
   Tax forms generated if required
9. System Reset:
   Jackpot amount for the triggered tier is reset
   All ETGTs updated to reflect new jackpot amounts
10. Logging and Reporting:
   Details of win, including the specific triggering combination, logged in central database
   Reports generated for accounting, regulatory compliance, and marketing purposes
11. Marketing Integration:
   System notifies marketing department of the jackpot win
   Details of the win (with player's permission) used for promotional materials

### Noteworthy Aspects and Features:

Cross-Game Integration: The system works across multiple card-based games, creating a unified jackpot experience.
Tiered Jackpot Structure: Multiple qualifying combinations allow for varied jackpot sizes and hit frequencies.
Instant Recognition: The system identifies winning combinations as soon as they're completed, creating immediate excitement.
Flexibility: Casinos may easily update qualifying combinations and jackpot tiers to keep the promotion fresh.
Educational Aspect: Players learn about valuable card combinations across different games.
Marketing Potential: Rare combinations create great stories for casino marketing and social media.
Scalability: The system may easily accommodate new card games or additional ETGTs.
Player Attraction: The possibility of huge jackpots from specific card combinations may attract players to card game ETGTs.

### Mystery Jackpot Triggering Criteria #6—Jackpot Contribution Milestone

### Description and IMPLEMENTATION:

This Mystery Jackpot trigger activates when a predetermined total of side bets contributing to the jackpot pool is reached. For example, in a networked live dealer game table (LDGT) or live Dealer-controlled Electronic Table Games (DETGs), each player placing a side bet contributes a fixed amount to a common jackpot pool. The system tracks these contributions cumulatively. When the total amount contributed reaches a milestone (e.g., $10,000), the Mystery Jackpot is triggered.

The system may set different milestones (e.g., $5,000, $10,000, etc.), with each milestone associated with various jackpot levels or additional rewards. This ensures that players are incentivized to make side bets in hopes of triggering the jackpot when the pool reaches its threshold. The implementation of this trigger may require real-time tracking of side bets across all participating tables in the casino network.

### Benefits to Players:

Players benefit from this trigger by having a clear understanding of how their side bets contribute toward a potential jackpot, giving them more control over their gameplay. The increasing pool milestone also creates excitement, especially as the jackpot nears the threshold, encouraging players to participate in side bets. The transparency of the growing jackpot pool fosters a sense of communal excitement.

### Benefits to Casinos:

This trigger incentivizes side bets, which in turn generates additional revenue for casinos. By setting multiple milestones, casinos encourage continued engagement, as players are drawn to the possibility of triggering different jackpot levels. This trigger may also be promoted as a feature in marketing campaigns, particularly in competitive gaming markets like Macau, where attracting and retaining players is desirable.

### Example Walk-Through Scenario:

At a baccarat table, each player is given the option to place a side bet that contributes to a shared jackpot pool.

The system announces the current jackpot pool size, which has been steadily growing from contributions across all connected terminals in the casino. At the beginning of each game round, players place their regular bets on the outcome of the hand and have the option to place an additional side bet of $5, which goes toward the jackpot.

As the night progresses, the cumulative contributions to the pool from all players across multiple terminals reach $9,900. Several players at the table, noticing the rising total, eagerly place side bets in the next round. After the round concludes and another $200 is added to the pool, the system detects that the $10,000 milestone has been reached, triggering the Mystery Jackpot. One player, randomly selected from those who contributed a side bet, wins the jackpot.

The sudden activation of the jackpot brings excitement to the table and the casino floor, drawing attention from other players. Seeing the potential for future milestones, other players are motivated to place more side bets, fueling further participation and engagement.

### Example System Procedural Flow:

1. Player Places Side Bet:
   Each player at an ETGT or LDGT places their wager for the main game and optionally a side bet that contributes to the jackpot pool. The system records the side bet amounts from each terminal.
2. Side Bet Contribution Update:
   The ETGT or LDGT system transmits the side bet amounts to the casino's central server, where the contributions are added to a shared jackpot pool.
3. Milestone Tracking:
   The central server monitors the cumulative jackpot total. When it detects that the total contributions have reached a pre-defined milestone (e.g., $10,000), the system prepares to trigger the Mystery Jackpot.
4. Jackpot Trigger:
   Upon reaching the milestone, the system randomly selects one of the players who contributed a side bet in the qualifying round. The jackpot amount is awarded to that player, and the pool is reset for the next jackpot cycle.
5. Payout:
   The winning player is notified via their ETGT or LDGT terminal, and the jackpot is credited to their account or paid out through the terminal. The system logs the event for record-keeping.
6. Data Logging:
   The system logs the jackpot trigger, including the milestone reached, total jackpot amount, and the identity of the winning player. This information is stored for auditing and reporting purposes.

Noteworthy Aspects and Features:

This trigger leverages communal play by using pooled contributions, creating a shared experience among all participating players. The notable innovation lies in its transparency and milestone-based progression, which enhances player engagement and casino profitability. Unlike traditional jackpot triggers based on individual outcomes, this communal approach encourages continuous player participation and aligns with modem trends in social gaming.

### Mystery Jackpot Triggering Criteria #7—Cross-Casino Milestone

### Description and Implementation:

The Cross-Casino Milestone criterion activates a Mystery Jackpot when a specified number of players across different casinos, linked via a shared network, are simultaneously playing at live dealer tables or ETGTs. For example, if casinos A, B, and C are part of a network, and the system detects that 500 players across these casinos are actively participating, the jackpot is triggered.

This criterion leverages multi-location play, adding an extra layer of engagement by linking players across different venues. Each casino contributes to a shared milestone, increasing the likelihood of reaching the trigger, which may be broadcast across all participating locations.

### Benefits to Players:

Players enjoy the collective excitement of being part of a larger, cross-casino gaming experience. Knowing that they are contributing to a milestone with other players from different locations adds a sense of community. This feature also heightens the anticipation as players monitor participation levels, eager to see if the milestone will be reached during their session.

### Benefits to Casinos:

Casinos benefit from increased player retention, as this cross-casino trigger encourages patrons to remain at the tables longer, waiting for the milestone to be achieved. It also fosters collaboration between casinos in the network, enabling shared marketing opportunities and promotions around the collective jackpot milestone.

### Example Walk-Through Scenario:

A network of casinos in Macau is running a promotion featuring the Cross-Casino Milestone Mystery Jackpot. At each participating casino, players are informed of the collective player count across all linked locations. As the number of active participants increases, the system updates the display to show how close the network is to reaching the milestone.

When the total player count hits 500 across the entire network, the jackpot is triggered, and a winner is selected from all participating players. At Casino B, one player is notified that they have won the jackpot, creating excitement not only at their location but across the entire network. The announcement is displayed on screens at all participating casinos, further encouraging players to continue engaging with the promotion.

### Example System Procedural Flow:

1. Player Participation:
   Players log into their ETGTs or LDGTs, and the system tracks the number of active participants across all networked casinos.
2. Milestone Tracking:
   The casino network's central server monitors the total number of players across all participating casinos. When the specified threshold is met, the system prepares to trigger the jackpot.
3. Jackpot Trigger:
   Once the player milestone is reached, the system triggers the Mystery Jackpot and randomly selects a winner from the pool of active players across all casinos.
4. Payout and Announcement:
   The system notifies the winning player through their terminal. Simultaneously, the network broadcasts the event to all linked casinos, informing players of the milestone reached and the jackpot payout.
5. Data Logging and Reset:
   The event is logged, and the system resets the player counter for the next milestone cycle.

### Noteworthy Aspects and Features:

The Cross-Casino Milestone trigger is unique in its use of multi-location play to foster a sense of shared achievement among players. This trigger's innovation lies in its ability to create a unified gaming experience across multiple venues, enhancing both player retention and casino profitability.

### Mystery Jackpot Triggering Criteria #8—Dealer-Specific Trigger

### Description and Implementation:

This Mystery Jackpot is triggered when the live dealer at an LDGT or DETG experiences a specific event, such as winning or losing a predefined number of consecutive hands. For example, if a dealer wins five consecutive rounds in blackjack, the system triggers the Mystery Jackpot. This trigger introduces an additional dynamic element to gameplay by directly involving the dealer's performance. The system tracks the dealer's win/loss record in real-time and activates the jackpot when the predefined condition is met.

### Benefits to Players:

Players are incentivized to stay engaged, as they anticipate the dealer hitting the required win/loss streak to trigger the jackpot. The dealer's performance adds another layer of excitement, making every round more significant.

### Benefits to Casinos:

This criterion promotes longer play sessions, as players remain invested in the game, waiting for the dealer's streak to activate the jackpot. It also adds a novel marketing element, as casinos may promote special events where dealer-specific triggers are more likely.

### Example Walk-Through Scenario:

At a blackjack table, players notice that the dealer has just won three consecutive rounds. Knowing that the Mystery Jackpot triggers after five dealer wins, players become more invested in each subsequent round. The system tracks the dealer's performance, and after the fifth consecutive win, the jackpot is triggered. One lucky player is randomly selected as the jackpot winner.

### Example System Procedural Flow:

1. Dealer Performance Tracking:
   The system monitors the dealer's win/loss record in real-time, updating the consecutive wins or losses after each round.
2. Trigger Condition Check:
   After each game, the system checks if the dealer has achieved the predefined win/loss streak. Once the streak condition is met, the Mystery Jackpot is triggered.
3. Player Selection and Payout:
   A player from the active participants is randomly selected to win the jackpot, and the system credits the prize to their account or terminal.

### Noteworthy Aspects and Features:

This dealer-focused trigger adds an extra dimension to gameplay by incorporating the dealer's performance into the jackpot system, creating a dynamic and interactive experience for players.

### Mystery Jackpot Triggering Criteria #9—All Players Bet on Same Outcome

### Description and Implementation:

This trigger activates when all players at an LDGT or DETG place their bets on the same outcome, such as all players betting on the banker in a game of baccarat. The system detects when every player at the table or networked terminals places identical bets and triggers the Mystery Jackpot.

This criterion enhances the social aspect of casino gaming, as players work together, either by chance or through cooperation, to trigger the jackpot.

### Benefits to Players:

Players experience a sense of camaraderie and teamwork, knowing that they all stand to benefit from a unified betting strategy. This adds a social dynamic to gameplay, as players may encourage each other to bet on the same outcome to trigger the jackpot.

### Benefits to Casinos:

This trigger promotes player interaction and increases engagement, as players work together to achieve a shared goal. Casinos may also use this feature to encourage specific betting patterns, driving higher revenue from table games.

### Example Walk-Through Scenario:

At a baccarat table, all players coincidentally place their bets on the banker for a particular round. The system detects that all bets are on the same outcome and triggers the Mystery Jackpot. One of the players is selected as the winner, receiving the jackpot prize, while the others enjoy the collective excitement of having participated in a winning strategy.

### Example System Procedural Flow:

1. Bet Monitoring:
   The system tracks the bets placed by each player at the table or across multiple ETGTs, checking for identical bets on a specific outcome.
2. Trigger Condition Check:
   Once all players have placed identical bets, the system activates the Mystery Jackpot and randomly selects a winner.
3. Payout:
   The selected player receives the jackpot prize, and the system logs the event.

### Noteworthy Aspects and Features:

This trigger stands out for its social and collaborative nature, encouraging players to work together to achieve a common goal.

### Mystery Jackpot Triggering Criteria #10—Game-Specific Trigger

### Description and Implementation:

The Game-Specific Trigger activates the Mystery Jackpot when a specific event occurs within a particular game. For example, in blackjack, a player getting two aces of the same suit, or in baccarat, a tie with a total of 8 may trigger the jackpot. This trigger is tailored to the unique features of each game, allowing the casino to customize the triggering conditions based on game-specific rules.

The system monitors the gameplay in real-time to identify when the game-specific event has occurred. This trigger may apply to various games like poker, roulette, or baccarat, each with its own set of conditions that activate the jackpot. For implementation, the system uses algorithms that track card combinations, dice rolls, or wheel spins across multiple ETGTs.

### Benefits to Players:

Players appreciate the excitement added by these unique, game-specific events. Knowing that a rare event may trigger a jackpot adds a layer of anticipation and encourages players to stay engaged with the game. It also rewards players for understanding the intricacies of the game, as they become more familiar with the game-specific conditions that lead to a jackpot.

### Benefits to Casinos:

For casinos, this trigger increases engagement by highlighting the potential for a jackpot win based on exciting in-game events. It creates a more interactive and customized experience for players, promoting longer play sessions. Additionally, these unique triggers may be used in marketing to attract players to specific tables or games where the conditions are more to occur.

### Example Walk-Through Scenario:

In a live dealer blackjack game at an ETGT, a player is dealt two aces of spades in a single hand. This rare event immediately triggers the Mystery Jackpot, surprising the player and adding an unexpected reward to their game session. The system recognizes the card combination and instantly activates the jackpot, distributing the prize to the winning player. Other players observing the event are encouraged to continue playing, hoping that they too may experience a jackpot-triggering event.

### Example System Procedural Flow:

1. Game Round Initiation:
   The system tracks all cards dealt or outcomes generated by the ETGT or LDGT.
2. Event Detection:
   The system compares the ongoing game results to predefined game-specific conditions (e.g., a specific card combination or total) and identifies a match.
3. Trigger Activation:
   When the specific game event occurs, the system activates the Mystery Jackpot.
4. Payout:
   The system announces the jackpot win to the player who triggered the event, and the jackpot amount is credited to their account.
5. Event Logging:
   The system logs the game event and the jackpot payout for record-keeping.

### Noteworthy Aspects and Features:

The Game-Specific Trigger is highly customizable and adaptable to the unique elements of each game, allowing for a more personalized experience for players. It creates additional excitement around rare game events and adds an extra layer of unpredictability to the gameplay.

### Mystery Jackpot Triggering Criteria #11—Side Bet Multiplier Activation

### Description and Implementation:

This Mystery Jackpot is triggered when a player places a side bet that activates a random multiplier within the game. For example, in a game of blackjack or baccarat, players have the option to place side bets that may multiply their winnings. When a player hits a winning combination and a multiplier is randomly applied, the system triggers the Mystery Jackpot.

This trigger may require the ETGT or LDGT system to monitor all side bets and apply multipliers based on predetermined odds. The system may be designed to offer various multipliers (e.g., 2×, 5×, 10×), and the jackpot is triggered when the highest multiplier is activated.

### Benefits to Players:

Players enjoy the thrill of the unexpected multiplier, which may significantly enhance their winnings. The potential for a multiplier to trigger a jackpot adds excitement and encourages players to place side bets more frequently. It also enhances the overall gaming experience by offering larger rewards for riskier plays.

### Benefits to Casinos:

For casinos, this trigger increases the volume of side bets, leading to higher revenue. The excitement generated by the random multipliers may lead to longer play sessions and more frequent participation. Additionally, the multiplier system may be customized to increase player retention by adjusting the odds of triggering a jackpot.

### Example Walk-Through Scenario:

In a baccarat game at an ETGT, a player places a side bet on the tie outcome, which carries a higher risk but offers larger rewards. When the tie occurs, a random multiplier of 10× is applied to the player's winnings. This triggers the Mystery Jackpot, and the system announces the win across all terminals. The player receives both their multiplied winnings and the jackpot payout, creating a surge of excitement on the gaming floor.

### Example System Procedural Flow:

1. Side Bet Placement:
   The player places a side bet, and the system records the amount and type of bet.
2. Game Round Execution:
   The system processes the game round and identifies the outcome. If the outcome matches the player's side bet, the system applies a random multiplier to the winnings.
3. Multiplier Check:
   The system checks if the multiplier meets the jackpot-triggering condition (e.g., the highest possible multiplier).
4. Jackpot Activation:
   If the condition is met, the Mystery Jackpot is triggered, and the system awards the player the jackpot in addition to their multiplied winnings.
5. Event Logging:
   The system logs the side bet, multiplier applied, and jackpot payout for auditing and compliance purposes.

### Noteworthy Aspects and Features:

This trigger combines the excitement of multipliers with the potential for a jackpot, creating a high-reward scenario for players. It adds depth to side betting strategies and may be fine-tuned by casinos to enhance player retention and revenue.

Mystery Jackpot Triggering Criteria #12—Specific Player Action Sequence

### Description and Implementation:

This trigger activates when a player performs a predefined sequence of actions during a game session. For example, in blackjack, a player may trigger the jackpot by hitting, standing, and doubling down in a specific order during a single round. The sequence is unique to the game and may be customized to include various game actions, such as splits, re-buys, or additional side bets.

The system monitors each player's actions in real-time, analyzing whether the specific sequence of actions has been completed. This trigger encourages strategic play, as players who are aware of the sequence may adjust their actions to try to meet the conditions.

### Benefits to Players:

Players are rewarded for taking calculated risks and making strategic decisions. The possibility of triggering a jackpot through specific game actions adds an exciting challenge, encouraging players to experiment with different strategies. This trigger also enhances player engagement, as it rewards active participation in the game.

### Benefits to Casinos:

Casinos benefit from longer and more engaged gameplay as players attempt to achieve the required sequence of actions. This trigger promotes strategic play, which may increase the complexity and depth of player interaction with the game. Additionally, it creates opportunities for casinos to highlight and promote these specific action sequences in marketing campaigns.

### Example Walk-Through Scenario:

In a blackjack session at an ETGT, a player makes a series of strategic decisions: first hitting to draw another card, then standing with a strong hand, and finally doubling down on the next round. The system recognizes this specific sequence of actions as the trigger for the Mystery Jackpot. The player wins the jackpot, and the system displays the event across the casino, drawing the attention of other players and encouraging them to stay engaged.

### Example System Procedural Flow:

1. Action Tracking:
   The system monitors the player's actions during each game round, recording each decision (hit, stand, double down, etc.).
2. Sequence Check:
   The system continuously checks if the player's actions match the predefined sequence required to trigger the jackpot.
3. Jackpot Activation:
   When the sequence is completed, the system activates the Mystery Jackpot and awards the prize to the player.
4. Event Announcement:
   The system displays the jackpot win across the casino and credits the player's account with the jackpot amount.
5. Logging and Compliance:
   The system logs the specific actions taken by the player, the triggering sequence, and the jackpot payout for auditing purposes.

### Noteworthy Aspects and Features:

This trigger rewards strategic play and adds depth to gameplay by encouraging players to think about their actions. It may be tailored to different games and creates a more interactive gaming experience.

### Mystery Jackpot Triggering Criteria #13—Session Time Trigger

### Description and Implementation:

The Session Time Trigger activates the Mystery Jackpot when a player exceeds a specific session duration. For example, if a player has been continuously playing for more than 60 minutes at an ETGT or LDGT, the jackpot is triggered. The system tracks the duration of each player's session and automatically activates the jackpot once the time threshold is reached.

This trigger rewards long-term engagement and encourages players to remain active at the table. It may be customized based on game type or casino preferences, with different session durations required to trigger the jackpot for different games.

### Benefits to Players:

Players are incentivized to stay longer at the gaming table, knowing that extended playtime may result in a jackpot win. This trigger also rewards loyalty and persistence, creating a more immersive experience. Players who prefer longer sessions are more to feel rewarded for their continued engagement.

### Benefits to Casinos:

For casinos, this trigger promotes longer play sessions, which directly correlates with increased revenue. It also helps in retaining players, as they are motivated to continue playing in hopes of triggering the jackpot based on session duration. Additionally, the Session Time Trigger may be used as a promotional tool to attract players to stay at the tables for extended periods.

### Example Walk-Through Scenario:

A player sits down at an ETGT and begins a session of roulette. After playing for over an hour, the system detects that the player's session time has exceeded the 60-minute threshold. The Mystery Jackpot is automatically triggered, and the player wins the jackpot as a reward for their continued play. The system announces the win to all players, encouraging others to extend their sessions as well.

### Example System Procedural Flow:

1. Session Time Tracking:
   The system tracks the length of time each player has been active at their ETGT or LDGT terminal.
2. Threshold Check:
   The system continuously monitors the session duration and checks if the player has exceeded the predefined time limit.
3. Jackpot Activation:
   When the session time threshold is reached, the system triggers the Mystery Jackpot.
4. Payout and Notification:
   The player is notified of the jackpot win, and the prize is credited to their account or paid out via the terminal.
5. Logging:
   The system logs the session duration, player details, and jackpot payout for record-keeping.

### Noteworthy Aspects and Features:

The Session Time Trigger is particularly effective at promoting player retention by rewarding extended gameplay. It encourages players to remain engaged and may be tailored to different games and session lengths to optimize retention strategies.

Mystery. Jackpot Triggering Criteria #14—Cross-Game Bonus Trigger

### Description and Implementation:

The Cross-Game Bonus Trigger activates a Mystery Jackpot when a player meets certain conditions across multiple different DETG games. For example, a player who wins in two consecutive games-such as blackjack and baccarat-within a session may trigger the jackpot. This criterion encourages players to engage in different games rather than sticking to a single one.

The system tracks the player's progress across various games on the network, linking outcomes from different tables or terminals to the same player ID. This trigger may be configured to may require specific combinations, such as winning three different games in a row (e.g., roulette, blackjack, and poker) or achieving a certain condition (like receiving a royal flush in poker and then a blackjack win). The system integrates results across these games, analyzing and determining when the cross-game condition is met.

### Benefits to Players:

Players benefit by having the opportunity to trigger jackpots by engaging in multiple games. This encourages variety in gameplay, which may make the overall experience more entertaining and engaging. It also rewards skilled players who may perform well across multiple game types. Additionally, this criterion introduces a strategic element to switching games in hopes of meeting the jackpot condition, providing an incentive to explore different options in the casino.

### Benefits to Casinos:

This trigger increases player engagement by promoting multi-game participation. Players are motivated to move from game to game in hopes of hitting the jackpot, which leads to increased session times and more betting activity. Casinos benefit from spreading player participation across multiple game terminals, ensuring that no single game or terminal becomes too congested. This also helps casinos balance player traffic between popular and less popular games.

### Example Walk-Through Scenario:

A player named Mei begins her session by playing blackjack at an ETGT. After winning two consecutive hands, she decides to switch to baccarat to keep her winning streak alive. She places her bet on the player hand and wins again. The system, tracking her progress, identifies that she has achieved wins in both blackjack and baccarat within a short time frame. As these two wins meet the predefined cross-game bonus conditions, the Mystery Jackpot is triggered. Mei receives an unexpected jackpot payout as a reward for her success across multiple games, while the other players at both the blackjack and baccarat tables take note of the event, encouraging them to explore different games in the hopes of replicating her success.

### Example System Procedural Flow:

1. Game Participation and Outcome Tracking:
   The system tracks each game outcome for the player, linking results to their player ID across multiple games.
2. Cross-Game Condition Check:
   As the player participates in different games, the system monitors whether the required combination of game outcomes (e.g., consecutive wins across games) has been achieved.
3. Jackpot Trigger:
   Once the system detects that the cross-game condition has been met (e.g., wins in both blackjack and baccarat), the Mystery Jackpot is activated.
4. Payout and Notification:
   The system notifies the player that they have triggered the jackpot, displaying the win across the casino and crediting the jackpot amount to their account.
5. Data Logging and Reporting:
   The system logs the cross-game conditions met, the player's activity, and the jackpot payout for audit and compliance purposes.

### Noteworthy Aspects and Features:

This trigger promotes multi-game engagement, incentivizing players to explore different types of DETG games. It enhances the gaming experience by providing a broader array of opportunities to win, making the overall casino experience more dynamic and engaging. By encouraging players to participate in several games, the trigger increases overall player activity.

### Mystery Jackpot Triggering Criteria #15—Jackpot Pool Size Milestone

### Description and Implementation:

The Jackpot Pool Size Milestone criterion triggers the Mystery Jackpot when the total jackpot pool reaches or exceeds a predefined amount, such as $500,000. As players across multiple ETGTs or LDGTs contribute to the jackpot through side bets or a percentage of their wagers, the pool steadily grows. Once it hits the target threshold, the system activates the Mystery Jackpot and randomly selects a player from those who contributed during the qualifying round.

This implementation may require the jackpot pool to be continuously updated and displayed to players, creating excitement as the pool size grows. The larger the pool becomes, the greater the anticipation among players that the jackpot may be triggered at any moment.

### Benefits to Players:

Players are highly motivated to place side bets and contribute to the jackpot pool, knowing that once it hits a certain size, one of them will win a substantial prize. The ever-growing pool creates an element of suspense, encouraging more participation as the threshold approaches. Players are also incentivized to stay longer and place more bets, increasing their chances of being selected as the jackpot winner once the milestone is reached.

### Benefits to Casinos:

For casinos, this trigger boosts revenue by encouraging players to place additional side bets to grow the jackpot pool. As the pool grows and nears the milestone, player retention increases, as players are eager to stay and increase their chances of winning. This also provides casinos with an opportunity to promote larger jackpots during peak times, drawing more players to the tables.

### Example Walk-Through Scenario:

In a busy casino, players across multiple ETGTs are actively placing bets in games like roulette, blackjack, and baccarat. Each game contributes a percentage of the bets to a shared jackpot pool, which is displayed on large screens throughout the casino. As the pool approaches the $500,000 milestone, excitement builds, and more players begin placing side bets, hoping to be the one to trigger the jackpot. When the pool hits the $500,000 mark, the system randomly selects one of the qualifying players who contributed to the pool, awarding them the jackpot prize.

### Example System Procedural Flow:

1. Side Bet Placement and Jackpot Pool Update:
   Players place side bets, and a portion of these bets is added to the growing jackpot pool. The current jackpot total is displayed in real-time.
2. Milestone Monitoring:
   The system continuously monitors the jackpot pool's total value, checking if it has reached the predefined milestone amount.
3. Jackpot Trigger:
   Once the pool size reaches the set threshold (e.g., $500,000), the system activates the Mystery Jackpot.
4. Player Selection and Payout:
   A player who contributed during the qualifying round is randomly selected as the jackpot winner, and the prize is credited to their account.
5. Data Logging and Jackpot Reset:
   The system logs the jackpot event, including the pool size, player contributions, and the winner's details. The pool is then reset for the next jackpot cycle.

### Noteworthy Aspects and Features:

This trigger leverages the excitement of a growing jackpot pool, encouraging player participation and retention. It creates a sense of anticipation as the milestone approaches, drawing more players to the game as the pool increases in size. The random selection of a winner adds an element of surprise, keeping players engaged.

### Mystery Jackpot Triggering Criteria #16—Multiplayer Match Trigger

### Description and Implementation:

The Multiplayer Match Trigger activates a Mystery Jackpot when two or more players across different terminals achieve the same specific outcome during the same game round. For example, two players in different terminals receiving identical blackjack hands or both hitting the same number in roulette may trigger the jackpot. This trigger relies on synchronized gameplay across multiple ETGTs or LDGTs, connecting the outcomes of different players to create a collaborative jackpot event.

The system tracks player outcomes in real-time and compares results across all active terminals. When it detects that the match condition is met, the jackpot is triggered, and the involved players either share the jackpot or one is selected randomly as the winner.

### Benefits to Players:

This trigger enhances the social aspect of gaming by linking players' outcomes across different terminals, creating a collaborative experience. Players feel a sense of camaraderie when they achieve matching outcomes, knowing that they have collectively triggered a jackpot. This feature adds an exciting twist to gameplay, as players are rewarded not just for their individual success but for matching outcomes with others.

### Benefits to Casinos:

Casinos benefit from increased player retention, as players are encouraged to stay in the game longer, hoping to achieve matching outcomes with others. The shared nature of this jackpot adds a unique social dynamic that may help differentiate the casino's offerings from competitors. Additionally, the excitement of triggering a jackpot through a multiplayer match may draw more players to networked ETGTs or LDGTs, increasing overall engagement.

### Example Walk-Through Scenario:

At two separate ETGTs, players John and Maria are both playing blackjack. During the same game round, both players are dealt identical hands: a pair of eights and an ace. The system recognizes this matching outcome and triggers the Multiplayer Match Jackpot. Both players are notified of the win and are either awarded a shared jackpot or one player is randomly selected to receive the full prize. The system broadcasts the jackpot event to other players, generating excitement across the casino floor.

### Example System Procedural Flow:

1. Player Outcome Tracking:
   The system monitors the outcomes of all players across networked terminals in real-time, recording the results of each game round.
2. Matching Condition Check:
   The system compares the outcomes of players participating in the same game round, checking for matching results (e.g., identical blackjack hands or matching numbers in roulette).
3. Jackpot Trigger:
   Once a match is detected, the system triggers the Mystery Jackpot, either splitting the prize among the matching players or selecting one as the winner.
4. Payout and Notification:
   The winning player(s) are notified via their terminal, and the jackpot prize is credited to their account.

The event is announced to other players to increase engagement.
5. Logging and Reset:
   The system logs the multiplayer match event, recording the matching outcomes, players involved, and the jackpot payout. The jackpot resets for the next qualifying event.

### Noteworthy Aspects and Features:

The Multiplayer Match Trigger enhances social interaction and collaboration between players across different terminals, creating a more dynamic and engaging gaming experience. This trigger adds an element of shared success, encouraging players to continue participating in hopes of matching outcomes with others. The collaborative nature of this jackpot makes it particularly appealing in networked gaming environments.

### Mystery Jackpot Triggering Criteria #17—Player Bet Frequency

### Description and Implementation:

The Player Bet Frequency criterion activates a Mystery Jackpot based on how frequently a player places bets within a specific time frame. For instance, the jackpot may trigger if a player places 10 bets in 5 minutes. This trigger is designed to reward active, fast-paced play, encouraging players to maintain consistent engagement with the game.

The system tracks the number of bets a player places during a game session, calculating the rate of bets over time. Once the player's betting frequency meets or exceeds the predefined threshold, the system triggers the Mystery Jackpot.

### Benefits to Players:

Players are incentivized to remain engaged and active during their session, as frequent betting increases their chances of triggering a jackpot. This adds a layer of excitement, as players are rewarded for their fast-paced play. Additionally, this trigger appeals to players who enjoy continuous action, providing a tangible benefit for their consistent engagement.

### Benefits to Casinos:

Casinos benefit from increased betting activity, as players are encouraged to place more frequent bets to trigger the jackpot. This leads to higher overall revenue from increased bet volume. Additionally, the Player Bet Frequency trigger may help reduce idle time at terminals, ensuring that players remain actively engaged in the game.

### Example Walk-Through Scenario:

A player at an ETGT is playing roulette and places several bets in quick succession, aiming to trigger the Player Bet Frequency Jackpot. The system tracks the number of bets placed over time and detects that the player has placed 10 bets within a 5-minute period. The jackpot is triggered, and the player is rewarded for their rapid betting activity. The system displays the jackpot win to other players, encouraging them to increase their bet frequency as well.

### Example System Procedural Flow:

1. Bet Tracking:
   The system monitors the player's bet placement in real-time, tracking the number of bets placed and the time between them.
2. Frequency Check:
   The system calculates the player's bet frequency and compares it to the predefined threshold (e.g., 10 bets in 5 minutes).
3. Jackpot Trigger:
   When the player's betting frequency meets the required condition, the system triggers the Mystery Jackpot.
4. Payout and Notification:
   The system notifies the player of the jackpot win, and the prize is credited to their account. The win is broadcast across other terminals to encourage more frequent betting.
5. Logging and Reset:
   The system logs the event, recording the player's bet frequency and the jackpot payout. The system resets for the next qualifying event.

### Noteworthy Aspects and Features:

The Player Bet Frequency trigger rewards active and consistent play, encouraging players to maintain a fast-paced gaming session. This trigger not only increases player engagement but also drives higher betting activity, resulting in increased casino revenue. By creating a sense of urgency to place more bets within a short time frame, this criterion keeps players fully immersed in the gaming experience.

### Mystery Jackpot Triggering Criteria #18—Special Dealer Event

### Description and Implementation:

The Special Dealer Event Mystery Jackpot trigger activates when a specific event involving the dealer occurs. For instance, the trigger may be set to activate when the dealer draws a particular card or achieves a certain outcome, such as a bust in blackjack with a specific hand. This jackpot condition directly involves the dealer's performance and adds a new dynamic where players eagerly watch the dealer's actions, knowing that they may lead to a jackpot event.

In live dealer table games (LDGTs) or live Dealer-controlled Electronic Table Games (DETGs), the system monitors the dealer's actions in real-time. The condition for the jackpot may be linked to various dealer outcomes such as the dealer winning or losing several rounds consecutively, drawing a specific combination of cards, or busting with a particular hand in blackjack. The system automatically tracks these events and activates the jackpot when the pre-defined condition is met.

### Benefits to Players:

For players, this trigger adds excitement by focusing on the dealer's actions, giving them something extra to anticipate during each round. It also engages all players at the table, as everyone benefits from the dealer's performance. The shared experience of watching the dealer hit the right outcome for a jackpot trigger may build a sense of camaraderie and excitement among players. Players are also rewarded for staying in the game longer, as they wait for the dealer to hit the right conditions to trigger the jackpot.

### Benefits to Casinos:

This trigger increases player retention, as it encourages players to stay longer in hopes of seeing the dealer trigger the jackpot. The focus on the dealer's actions keeps players engaged even when their own hands are less favorable. Casinos may also promote special events where the chances of the dealer hitting a jackpot-triggering outcome are enhanced, which may attract more players during certain periods.

### Example Walk-Through Scenario:

At a blackjack table, the dealer has just drawn a ten and a six, totaling 16. As the dealer deals themselves another card, the players watch closely, knowing that if the dealer busts with a seven (totaling 23), the Mystery Jackpot will be triggered. The tension builds, and when the dealer draws a seven, the jackpot condition is met. The system immediately triggers the Mystery Jackpot, and a randomly selected player is awarded the prize. The rest of the table celebrates the event, and the casino floor buzzes with excitement as players at nearby tables observe the win.

### Example System Procedural Flow:

1. Dealer Action Monitoring:
   The system tracks the dealer's actions in real-time, recording the cards dealt and the outcome of each round.
2. Special Event Condition Check:
   After each round, the system checks if the dealer's actions match the predefined condition (e.g., busting with a specific hand in blackjack).
3. Jackpot Trigger:
   If the dealer hits the special event condition, the system triggers the Mystery Jackpot.
4. Player Selection and Payout:
   The system selects a random player at the table to receive the jackpot payout, and the prize is credited to the player's account.
5. Event Logging:
   The system logs the dealer event and the jackpot trigger, including details of the dealer's hand and the selected player.

### Noteworthy Aspects and Features:

This dealer-focused trigger brings a new layer of excitement to table games by involving the dealer's performance in the jackpot mechanics. It encourages longer play sessions and enhances the social atmosphere at the table, as players collectively root for the dealer to hit the jackpot-triggering condition. By engaging players in this unique way, the casino fosters a more interactive gaming experience.

### Mystery Jackpot Triggering Criteria #19—Consecutive Wins Across Multiple Players

### Description and Implementation:

The Consecutive Wins Across Multiple Players criterion activates the Mystery Jackpot when multiple players at the same table or across different terminals achieve consecutive wins simultaneously. For instance, if three players each win five rounds in a row at the same baccarat table, the system triggers the jackpot. This trigger adds a collaborative aspect to the gameplay, where multiple players benefit from a shared streak of success.

In an ETGT or LDGT setup, the system monitors each player's win streak in real-time. The trigger condition may be set to activate when a specific number of players achieve a set number of consecutive wins, such as all players at a table winning five rounds in a row. The system links the players' outcomes, creating a communal jackpot experience.

### Benefits to Players:

Players are rewarded not only for their individual success but also for the collective achievements of others. This trigger encourages camaraderie as players cheer each other on, hoping that everyone may maintain their win streak to trigger the jackpot. It also adds excitement and suspense, as players know that their consecutive wins are helping to unlock a shared prize.

### Benefits to Casinos:

This trigger helps to increase player retention and engagement by promoting a communal atmosphere at the table. As players strive to maintain their win streaks and work together to trigger the jackpot, they are to stay longer at the table. Casinos benefit from the increased volume of bets as players continue to play in hopes of achieving consecutive wins. Additionally, the collaborative nature of this trigger may serve as a promotional tool, drawing players to participate in group-focused games.

### Example Walk-Through Scenario:

At a baccarat table, four players are enjoying a winning streak. Each player has won the last four consecutive rounds, and the excitement builds as they approach the fifth round, knowing that if they all win again, the Mystery Jackpot will be triggered. As the final cards are dealt, the dealer announces the results: all four players have won their fifth consecutive round. The system detects the achievement and triggers the jackpot, distributing the prize among the winning players. The sense of shared accomplishment energizes the table, and other players nearby are drawn in by the excitement.

### Example System Procedural Flow:

1. Player Win Streak Tracking:
   The system monitors each player's win/loss record during the game, tracking consecutive wins across multiple players.
2. Condition Check:
   The system checks if the required number of players has achieved the specified number of consecutive wins (e.g., three players winning five rounds in a row).
3. Jackpot Trigger:
   When the condition is met, the system triggers the Mystery Jackpot.
4. Payout Distribution:
   The jackpot prize is distributed among the players who achieved the consecutive win streak, with the prize either split equally or awarded to one random player.
5. Logging and Reset:
   The system logs the event, recording the players involved and the number of consecutive wins. The jackpot resets for the next qualifying event.

### Noteworthy Aspects and Features:

This trigger creates a shared, collaborative experience for players, encouraging teamwork and longer sessions as they strive to achieve consecutive wins together. The communal aspect of this trigger fosters a sense of camaraderie, making it particularly appealing in social gaming environments. It also helps casinos enhance player retention by offering a unique, multi-player jackpot opportunity.

### Mystery Jackpot Triggering Criteria #20—Specific Card Drawn

### Description and Implementation:

This Mystery Jackpot trigger activates when a specific card, such as the Queen of Hearts or Ace of Spades, is drawn during a game. The jackpot may be triggered by the dealer or a player drawing the card, depending on the game type. For instance, in a blackjack game, the Mystery Jackpot may be triggered when the dealer deals an Ace of Spades as the first card in a hand.

The system monitors the cards dealt during the game and identifies when the specific card condition is met. This trigger is flexible and may be customized for different games, allowing casinos to set different jackpot conditions based on rare card draws in games like poker, blackjack, and baccarat.

### Benefits to Players:

For players, this trigger adds excitement by introducing an additional element of anticipation to the game. Knowing that a specific card may trigger a jackpot keeps players engaged, even when they are not directly involved in the hand. The random nature of the card draw makes the jackpot feel more unpredictable and thrilling, adding another layer of suspense to each game round.

### Benefits to Casinos:

Casinos benefit from increased player engagement, as players stay longer in the game, hoping for the rare card to appear. This trigger also promotes a sense of excitement and suspense across the gaming floor, as the possibility of a jackpot win is always present with each new card dealt. Additionally, the casino may use this trigger as part of promotional events, highlighting specific card combinations that may trigger larger jackpots during certain times.

### Example Walk-Through Scenario:

During a poker session at an ETGT, a player is dealt the Queen of Hearts, the specific card designated to trigger the Mystery Jackpot. As soon as the card appears, the system detects the event and triggers the jackpot. The player is notified of their win via the terminal, and the jackpot payout is credited to their account. The excitement of the rare card draw captures the attention of other players at the table, who are now eager to continue playing in hopes of seeing the next jackpot-triggering card appear.

### Example System Procedural Flow:

1. Card Tracking:
   The system monitors each card dealt during the game, checking for the specific card designated to trigger the jackpot (e.g., Queen of Hearts).
2. Trigger Condition Check:
   The system verifies if the specific card has been drawn, either by the dealer or a player, depending on the game rules.
3. Jackpot Activation:
   Once the specific card is identified, the system triggers the Mystery Jackpot and notifies the player.
4. Payout and Notification:
   The jackpot prize is credited to the player's account, and the event is announced across the casino to draw attention to the win.
5. Logging and Reset:
   The system logs the card draw, the player who received the jackpot, and the payout details. The jackpot condition resets for the next qualifying card draw.

### Noteworthy Aspects and Features:

This trigger is simple yet effective, adding an element of unpredictability and excitement to every round of card play. Players are engaged not only in their own hands but also in watching for the specific card that may trigger the jackpot, making every card dealt a potential game-changer. The random nature of the card draw ensures that players remain attentive and excited throughout their gaming session.

### Mystery Jackpot Triggering Criteria #21—Player Choice Jackpot Activation

### Description and Implementation:

The Player Choice Jackpot Activation trigger allows a player to decide when to activate a Mystery Jackpot by making a special selection during gameplay. For example, in a game of blackjack, a player may be given the option to place an additional wager or hit a bonus button at a strategic moment, with the chance of triggering the jackpot.

The system provides players with this option during notable moments in the game, such as when they have a winning hand or are about to make a final decision. The player's choice to activate the potential jackpot may depend on various in-game conditions, such as having a strong hand or achieving a specific win condition. This feature adds an element of control and strategy, allowing players to take an active role in determining when the jackpot is triggered.

### Benefits to Players:

Players enjoy the added control and strategy of being able to choose when to activate the jackpot, giving them a sense of agency over the outcome. This trigger also introduces a new layer of excitement and suspense, as players weigh the risk and reward of trying to activate the jackpot at a strategic moment. The Player Choice trigger also enhances the interactive nature of the game, making it more immersive and engaging.

### Benefits to Casinos:

Casinos benefit from increased engagement, as players are motivated to participate actively in the game to maximize their chances of triggering the jackpot. The introduction of a player-controlled jackpot trigger encourages more strategic play, leading to longer sessions and higher bet volumes. Additionally, casinos may promote this feature to attract players who enjoy games that offer more control and decision-making.

### Example Walk-Through Scenario:

In a blackjack game, a player has a hand totaling 18 and is given the option to hit a bonus button to activate the Player Choice Jackpot. The player decides to take the risk, selecting the bonus button, and the system triggers the jackpot based on their choice. The player is rewarded with a significant prize, and the excitement of being in control of the jackpot activation makes the moment even more thrilling. Other players at the table observe the event, encouraged to take similar risks when given the chance.

### Example System Procedural Flow:

1. Player Decision Point:
   The system identifies notable moments in the game where the player may be offered the choice to activate the jackpot (e.g., a high-value hand in blackjack).
2. Player Selection:
   The player is prompted to make a choice, such as hitting a bonus button or placing an additional wager, to attempt to activate the jackpot.
3. Jackpot Trigger:
   If the player's choice leads to a successful outcome, the system triggers the Mystery Jackpot.
4. Payout and Notification:
   The player is notified of their win, and the jackpot prize is credited to their account. The event is announced across the casino floor.
5. Logging and Reset:
   The system logs the player's decision and the outcome, including the jackpot activation and payout.

The trigger resets for the next eligible player choice.

### Noteworthy Aspects and Features:

The Player Choice Jackpot Activation trigger stands out by giving players control over the jackpot event, adding an element of strategy and personal involvement. It enhances player engagement and creates a more interactive gaming experience, encouraging players to stay invested in the game longer. The ability to choose when to trigger the jackpot also adds a unique twist to traditional gameplay, making it a compelling feature for both casual and experienced players.

### Mystery Jackpot Triggering Criteria #22—Near-Miss Outcome

### Description and Implementation:

The Near-Miss Outcome Mystery Jackpot triggers when a player almost achieves a specific winning condition, such as missing a royal flush by just one card in poker, or coming within one point of a perfect blackjack hand. This jackpot adds a consolation prize for players who narrowly miss a big win, rewarding them for their close call.

In an ETGT or LDGT system, the game monitors each hand, spin, or outcome to identify near-miss situations based on predefined conditions. These conditions may be narrowly missing a winning combination in poker, roulette, or blackjack. Once the near-miss condition is detected, the system triggers the jackpot, offering the player an unexpected prize despite not winning the main game.

### Benefits to Players:

Players benefit from the excitement and encouragement that comes with being rewarded for near misses, which may otherwise be a source of frustration. The Mystery Jackpot turns a potential loss into a positive experience, motivating players to keep playing and not give up after a close call. It also adds another level of engagement, as players are aware that even a near miss may lead to a significant payout, providing an added incentive to stay in the game longer.

### Benefits to Casinos:

For casinos, this trigger helps to reduce player frustration and improve player retention by rewarding those who come close to a win but fall short. By turning near misses into an opportunity for a jackpot, casinos may keep players engaged and prevent them from leaving after a frustrating loss. This feature also creates excitement and suspense, as players know they may be rewarded for being on the brink of a big win, further enhancing player engagement and time spent at the table.

### Example Walk-Through Scenario:

A player at a poker table is dealt a hand with four cards needed for a straight flush, but the fifth card just misses the mark. Although the player didn't win the hand, the system detects the near-miss outcome and triggers the Mystery Jackpot. The player is notified of the jackpot win, receiving a prize that softens the blow of missing out on a big hand.

The event sparks interest among other players at the table, who realize that even when they narrowly miss a win, they may still be rewarded with a jackpot.

### Example System Procedural Flow:

1. Game Monitoring:
   The system tracks the player's game outcomes in real-time, identifying situations where the player comes close to a winning hand but misses by a narrow margin.
2. Condition Check:
   The system checks if the player's outcome matches the predefined near-miss conditions (e.g., missing a straight flush or blackjack by one card).
3. Jackpot Trigger:
   If the near-miss condition is met, the system triggers the Mystery Jackpot.
4. Payout and Notification:
   The player is notified of the jackpot win and the prize is credited to their account. The event is announced across the casino floor to generate excitement.
5. Logging and Reset:
   The system logs the near-miss event, the player's details, and the jackpot payout. The jackpot resets for the next eligible near-miss event.

### Noteworthy Aspects and Features:

This trigger turns potentially frustrating near-miss situations into rewarding moments, encouraging players to stay engaged even when they narrowly miss a big win. The random yet predictable nature of this jackpot ensures that players remain hopeful and motivated, knowing that even a near-miss may lead to an unexpected reward. This helps reduce chum and keeps players active longer.

### Mystery Jackpot Triggering Criteria #23—High Roller Activation

### Description and Implementation:

The High Roller Activation Mystery Jackpot is triggered when a player places a high-value bet above a specific threshold, such as a $1,000 wager on blackjack or a $500 bet on roulette. This jackpot is specifically designed to reward players who are willing to take significant risks by placing large bets. The system identifies these high-stakes bets and automatically triggers the jackpot when the player meets the required betting threshold.

This trigger may be applied across multiple games, from high-stakes poker to baccarat, and encourages high rollers to engage in bigger bets with the added allure of a possible jackpot reward. The system tracks the size of bets placed and instantly recognizes when a player qualifies for the jackpot based on their wager size.

### Benefits to Players:

Players who enjoy high-stakes gambling are incentivized by the possibility of triggering a jackpot simply by placing large bets. The potential for a jackpot win makes high-stakes play even more exciting, rewarding players for their willingness to take risks. This trigger also appeals to players who prefer to place larger bets and enjoy the thrill of being rewarded for their high-roller status.

### Benefits to Casinos:

For casinos, this trigger encourages larger bets and higher revenue. By offering a jackpot reward for high-stakes play, casinos may attract high rollers and keep them engaged with the promise of a significant reward. This feature also provides a promotional tool for casinos to highlight exclusive high-roller events or tables where the jackpot is more to be triggered due to the betting thresholds.

### Example Walk-Through Scenario:

At a high-stakes baccarat table, a player places a $2,000 wager on the banker. The system detects the high bet, which exceeds the $1,000 threshold required to trigger the High Roller Activation Mystery Jackpot. The player wins the hand, and at the same time, the jackpot is triggered as a reward for their high-stakes wager. The system notifies the player of the jackpot win, and the prize is credited to their account. Other players at the table take notice, realizing that high-stakes play may also reward them with a jackpot.

### Example System Procedural Flow:

1. Bet Size Monitoring:
   The system tracks the size of bets placed by each player in real-time, recording wagers across different tables and games.
2. Threshold Check:
   The system compares the player's bet against the predefined threshold (e.g., $1,000) to determine if it qualifies for the High Roller Activation Jackpot.
3. Jackpot Trigger:
   If the player's bet meets or exceeds the threshold, the system triggers the Mystery Jackpot.
4. Payout and Notification:
   The player is notified of their jackpot win, and the prize is credited to their account. The event is announced to other players to promote high-stakes betting.
5. Logging and Reset:
   The system logs the high-stakes bet, the jackpot trigger, and the payout details. The jackpot resets for the next eligible high-stakes wager.

### Noteworthy Aspects and Features:

This trigger is designed specifically for high rollers, adding an extra incentive for placing large bets. It encourages risk-taking and rewards players for their high-stakes play, while also driving higher bet volumes for the casino. The High Roller Activation Jackpot adds an exclusive feel to the gaming experience, making it particularly attractive to VIP players.

### Mystery Jackpot Triggering Criteria #24—Tournament Participation Bonus

### Description and Implementation:

The Tournament Participation Bonus Mystery Jackpot is triggered when a player enters and participates in a special tournament event, such as a poker tournament, blackjack tournament, or roulette competition. This jackpot encourages players to engage in competitive events, rewarding them for their participation rather than their performance in the tournament itself.

In a DETG or LDGT environment, the system tracks player participation in scheduled tournaments and triggers the jackpot for all registered participants or randomly selects a winner from the participants. This feature adds an extra incentive for players to join tournaments, knowing that they have a chance to win a Mystery Jackpot simply by taking part.

### Benefits to Players:

Players are motivated to participate in tournaments with the added possibility of triggering a Mystery Jackpot, which may enhance the competitive atmosphere and make the event more exciting. Even players who may not expect to win the tournament itself are encouraged to participate, knowing they may still walk away with a jackpot. This feature adds value to tournament play and increases player engagement throughout the event.

### Benefits to Casinos:

Casinos benefit from increased tournament participation, which leads to higher entry fees and bet volumes. By offering a Mystery Jackpot for tournament participants, casinos may attract a wider range of players, including those who may not typically join competitive events. This feature also helps fill tournament spots more quickly, ensuring that the event is well-attended and generating more excitement on the gaming floor.

### Example Walk-Through Scenario:

A casino is hosting a blackjack tournament with 50 participants. Each player who registers is automatically entered into the Tournament Participation Bonus Mystery Jackpot, which will be triggered at a random point during the tournament. Halfway through the tournament, the system randomly selects one of the participants and triggers the jackpot, awarding them a substantial prize. The event creates a buzz among the remaining players, motivating them to stay engaged and encouraging others to participate in future tournaments for a chance to win a jackpot.

### Example System Procedural Flow:

1. Tournament Registration and Participation:
   The system registers players who enter the tournament, tracking their participation and assigning each participant a unique identifier.
2. Jackpot Eligibility Check:
   The system checks that each player has completed the required tournament registration and participation steps, ensuring they qualify for the jackpot.
3. Jackpot Trigger:
   At a random point during the tournament or at the end of the event, the system triggers the Mystery Jackpot, either awarding it to all participants or selecting a random winner.
4. Payout and Notification:
   The winning player(s) are notified of their jackpot win, and the prize is credited to their account. The jackpot event is announced to increase excitement during the tournament.
5. Logging and Reset:
   The system logs the tournament details, participant information, and the jackpot payout. The jackpot is reset for the next tournament event.

### Noteworthy Aspects and Features:

This trigger enhances tournament participation by offering a jackpot as an additional prize for players, regardless of their performance. It encourages players to join competitive events and boosts engagement, while also increasing tournament attendance and revenue for the casino. The random nature of the jackpot adds an element of surprise, making the tournament more exciting for all participants.

### Mystery Jackpot Triggering Criteria #25—Hot Streak Duration

### Description and Implementation:

The Hot Streak Duration Mystery Jackpot is triggered when a player maintains a winning streak for a certain period, such as 30 minutes or an hour, at an ETGT or LDGT. This trigger rewards consistent success over a sustained period, adding excitement and motivation for players to continue their winning streak. The system tracks the player's wins in real-time and monitors the duration of their streak, activating the jackpot when the player reaches the predefined time threshold while still winning.

This jackpot may apply across a variety of games, from blackjack to poker to roulette. It's especially appealing in games where streaks of success are possible, encouraging players to stay focused and engaged over extended periods.

### Benefits to Players:

Players are incentivized to stay at the table longer, knowing that a sustained winning streak may lead to a jackpot payout. The Hot Streak Duration trigger adds an additional layer of excitement to their gameplay, rewarding consistency and persistence. It also gives players a sense of achievement, as they are rewarded not just for a single big win, but for maintaining success over time.

### Benefits to Casinos:

For casinos, this trigger encourages longer play sessions, as players remain at the table in hopes of extending their winning streak to trigger the jackpot. The extended engagement leads to more bets placed and higher revenue. Additionally, the prospect of hitting a jackpot for maintaining a hot streak adds to the overall excitement on the casino floor, attracting attention from other players.

### Example Walk-Through Scenario:

A player at a blackjack table begins a winning streak, winning several hands in a row. As their streak continues, the system tracks both the number of consecutive wins and the duration of the streak. After the player maintains their winning streak for 45 minutes, the system triggers the Hot Streak Duration Mystery Jackpot, rewarding them with a bonus prize in addition to their regular winnings. The announcement of the jackpot win captures the attention of other players, who are now eager to achieve their own hot streaks in hopes of triggering the jackpot.

### Example System Procedural Flow:

1. Win Streak Tracking:
   The system tracks the player's win streak in real-time, recording both the number of consecutive wins and the total duration of the streak.
2. Duration Check:
   The system monitors the duration of the player's winning streak, checking if it meets the predefined time threshold (e.g., 30 minutes of continuous winning).
3. Jackpot Trigger:
   Once the player reaches the required duration while maintaining their win streak, the system triggers the Mystery Jackpot.
4. Payout and Notification:
   The player is notified of the jackpot win, and the prize is credited to their account. The event is announced to other players to promote continued engagement.
5. Logging and Reset:
   The system logs the player's streak duration, the jackpot payout, and resets the streak tracking for the next eligible player.

### Noteworthy Aspects and Features:

The Hot Streak Duration trigger rewards consistency and perseverance, offering players a chance to win a jackpot for maintaining a winning streak over time. It encourages longer play sessions and increased player engagement, while also adding an element of suspense as players try to keep their streak alive long enough to trigger the jackpot. This trigger is particularly appealing to players who enjoy the challenge of sustaining success over time, making it a powerful tool for player retention.

### Mystery Jackpot Triggering Criteria #26—Progressive Bet Contribution

### Description and Implementation:

The Progressive Bet Contribution Mystery Jackpot triggers when a player contributes to a progressive side bet pool, which grows over time as more players place bets. The jackpot is activated once the total contributions to the progressive pool reach a predefined threshold. This system incentivizes players to place side bets in addition to their regular wagers, with the knowledge that their contributions help build a shared jackpot pool that any contributing player may win.

In an ETGT or LDGT environment, the system tracks all player contributions to the progressive side bet in real time, updating the jackpot pool continuously. When the total contributions hit a specific milestone (e.g., $50,000), the system randomly selects a player who placed a qualifying side bet during that round and awards them the jackpot.

### Benefits to Players:

Players are motivated to place progressive side bets because they know that their contributions directly increase the jackpot pool, creating a communal sense of excitement. The potential for a substantial payout increases as the pool grows, keeping players engaged and eager to place more side bets. This trigger also rewards players for contributing, even if they do not win the regular game, giving them a chance to win a large prize simply for participating in the progressive bet.

### Benefits to Casinos:

Casinos benefit from increased betting activity, as players are incentivized to place more side bets, leading to larger progressive pools and more frequent jackpot triggers. The excitement of watching the progressive jackpot pool grow may also increase player retention, encouraging longer sessions and higher overall wager volumes. Additionally, the Progressive Bet Contribution trigger adds a layer of excitement that casinos may use to market their games, especially for players who enjoy contributing to a shared, growing prize pool.

### Example Walk-Through Scenario:

In a live blackjack game at an ETGT, each player has the option to place a $5 progressive side bet, which contributes to a shared jackpot pool. As more players place side bets, the pool grows, and the total contributions reach $50,000. The system detects that the milestone has been reached and randomly selects one of the players who placed a side bet during that round. The selected player wins the progressive jackpot, receiving a significant payout in addition to their regular game winnings. The event is announced across the casino floor, encouraging other players to place more side bets in hopes of winning the next jackpot.

### Example System Procedural Flow:

1. Side Bet Tracking:
   The system tracks all side bets placed by players, updating the progressive jackpot pool in real-time.
2. Contribution Monitoring:
   The system continuously monitors the total contributions to the progressive pool, checking if the predefined jackpot threshold has been reached.
3. Jackpot Trigger:
   Once the total contributions hit the threshold, the system randomly selects a player who placed a qualifying side bet during that round and triggers the Mystery Jackpot.
4. Payout and Notification:
   The jackpot prize is awarded to the selected player, and the event is announced across the casino. The system credits the prize to the player's account.
5. Logging and Reset:
   The system logs the jackpot event, including the total pool size, player contributions, and the winner's details. The progressive pool is then reset for the next jackpot cycle.

### Noteworthy Aspects and Features:

This trigger creates a dynamic and exciting experience for players by encouraging them to contribute to a growing jackpot pool. The Progressive Bet Contribution trigger fosters a sense of community, as players know their contributions are building a larger, shared prize. It also encourages longer play sessions and more frequent side betting, which benefits both players and casinos by increasing engagement and potential payouts.

### Mystery Jackpot Triggering Criteria #27—Rare Outcome Combinations

### Description and Implementation:

The Rare Outcome Combinations Mystery Jackpot is triggered when a player achieves an exceptionally rare combination of outcomes in a game, such as getting the same number on three consecutive roulette spins or hitting two blackjacks in a row with the same cards. This trigger is designed to reward players who experience highly unlikely sequences of events during gameplay, adding an element of surprise and excitement to the casino experience.

The system monitors all game outcomes in real-time, analyzing the probability of certain rare combinations occurring. When a player achieves one of these rare outcomes, the system triggers the Mystery Jackpot, providing an additional reward for their unusual luck.

### Benefits to Players:

For players, the Rare Outcome Combinations trigger adds an element of anticipation to every game round, as even the most unlikely events may lead to a significant payout. Players are rewarded for achieving rare and unexpected outcomes, which enhances the excitement of gameplay and keeps them engaged. This trigger also provides an incentive to continue playing, as players know that even the most improbable sequences may result in a jackpot win.

### Benefits to Casinos:

Casinos benefit from increased player engagement and retention, as players stay in the game longer in hopes of achieving a rare combination that triggers the jackpot. The thrill of hitting a highly improbable outcome keeps players excited and eager to continue playing. Additionally, this trigger creates memorable moments that may be highlighted in casino promotions, attracting new players and encouraging repeat visits from existing patrons.

### Example Walk-Through Scenario:

A player at a roulette table places consecutive bets on the number 17 and wins on three consecutive spins, an extremely rare event. The system recognizes this unusual sequence of outcomes and triggers the Mystery Jackpot, rewarding the player with a significant prize in addition to their roulette winnings. The rarity of the event creates a buzz among other players, who are now eager to stay at the table and try their luck at achieving their own rare outcome combinations.

### Example System Procedural Flow:

1. Outcome Monitoring:
   The system tracks the outcomes of each game in real-time, recording all results and combinations.
2. Probability Check:
   The system compares the player's outcomes to a predefined list of rare combinations, checking if the condition for a jackpot trigger is met (e.g., three consecutive identical outcomes).
3. Jackpot Trigger:
   When the rare outcome combination occurs, the system triggers the Mystery Jackpot, rewarding the player for their improbable achievement.
4. Payout and Notification:
   The player is notified of their jackpot win, and the prize is credited to their account. The event is announced to other players, generating excitement on the casino floor.
5. Logging and Reset:
   The system logs the rare outcome combination, the player's details, and the jackpot payout. The jackpot resets for the next qualifying rare combination.

### Noteworthy Aspects and Features:

This trigger adds an extra layer of excitement to the gameplay by rewarding players for achieving rare and improbable combinations of outcomes. It enhances the gaming experience by turning highly unlikely events into opportunities for jackpot wins, encouraging players to continue playing in hopes of replicating these rare occurrences. The Rare Outcome Combinations trigger also adds a memorable and unique element to the casino experience, creating stories that players will share with others.

### Mystery Jackpot Triggering Criteria #28—Time-Based Jackpot

### Description and Implementation:

The Time-Based Jackpot is triggered at specific intervals, such as every hour or every day, providing players with a chance to win a jackpot simply by participating in a game during the designated time frame. This criterion encourages players to stay engaged in gameplay, knowing that a jackpot will be triggered at a specific time regardless of the game's outcome. The system tracks the time of day and automatically activates the Mystery Jackpot when the predetermined time is reached.

This trigger may be applied across multiple games, including blackjack, poker, roulette, and baccarat, and it rewards players who are actively participating in gameplay when the jackpot is triggered. The system may either randomly select a player from all active participants or award the jackpot to the player who placed the most recent bet.

### Benefits to Players:

Players are incentivized to remain active in the game, knowing that a jackpot will be triggered at regular intervals. This feature adds excitement to gameplay, as players anticipate the jackpot trigger as the designated time approaches. The Time-Based Jackpot also rewards players for simply participating, giving them a chance to win a significant prize without needing to achieve a specific outcome in the game.

### Benefits to Casinos:

For casinos, this trigger increases player retention and engagement, as players are encouraged to stay in the game longer in hopes of being present when the jackpot is triggered. The time-based nature of the jackpot also allows casinos to manage player traffic more effectively, promoting certain games during peak times or slow periods. Additionally, casinos may use the Time-Based Jackpot as a marketing tool, highlighting specific time slots where jackpots are more to be triggered to attract more players.

### Example Walk-Through Scenario:

At a busy casino, players at multiple ETGTs and LDGTs are informed that a Mystery Jackpot will be triggered at exactly 10 p.m. As the time approaches, players increase their activity, placing more bets and staying engaged in the game. When the clock strikes 10, the system randomly selects one of the active players who placed a bet within the last minute, awarding them the jackpot prize. The excitement of the event encourages other players to remain active for the next hourly jackpot trigger.

### Example System Procedural Flow:

1. Time Tracking:
   The system tracks the time of day and identifies when the next jackpot trigger interval is approaching (e.g., every hour or at a specific time each day).
2. Player Participation Monitoring:
   The system monitors all active players across multiple games, recording the bets placed and participation levels.
3. Jackpot Trigger:
   When the predetermined time is reached, the system randomly selects one of the active players or the most recent bettor to receive the jackpot prize.
4. Payout and Notification:
   The selected player is notified of their jackpot win, and the prize is credited to their account. The event is announced across the casino to generate excitement.
5. Logging and Reset:
   The system logs the time of the jackpot trigger, the winning player's details, and the payout information. The time-based countdown is reset for the next interval.

### Noteworthy Aspects and Features:

This trigger rewards players for simply being present and active during specific time intervals, adding a layer of excitement to each game session. The anticipation of a regular jackpot trigger keeps players engaged and encourages longer play sessions, benefiting both the casino and the players. The Time-Based Jackpot is a powerful tool for managing player activity, especially during peak or slow times, and may be customized to suit the casino's operational needs.

### Mystery Jackpot Triggering Criteria #29—Cumulative Playtime

### Description and Implementation:

The Cumulative Playtime Mystery Jackpot rewards players who have accumulated a certain amount of total playtime, such as one hour or three hours, across one or multiple sessions. This jackpot is designed to encourage players to remain active over a longer period, as their cumulative playtime directly contributes to their eligibility for the jackpot. The system tracks the amount of time each player spends actively engaged in gameplay and triggers the jackpot when the predefined playtime threshold is reached.

This trigger applies across all games in the casino, allowing players to accumulate playtime regardless of the specific game they are participating in. The system monitors each player's session time and total playtime, updating their progress toward the jackpot.

### Benefits to Players:

Players are incentivized to stay in the game for longer periods, knowing that their cumulative playtime increases their chances of triggering the jackpot. This feature rewards persistence and loyalty, as players are rewarded not just for winning individual games but for the total amount of time they spend engaged in gameplay. The Cumulative Playtime trigger also provides players with a clear goal to work toward, adding excitement and motivation to their sessions.

### Benefits to Casinos:

For casinos, this trigger encourages extended play sessions, leading to higher bet volumes and increased revenue. By rewarding players for cumulative playtime, casinos may foster player loyalty and engagement, as players are motivated to return for additional sessions to reach the jackpot threshold. This feature also helps casinos increase the total time players spend at their terminals, improving overall traffic and activity levels on the gaming floor.

### Example Walk-Through Scenario:

A player participates in multiple blackjack and roulette sessions throughout the evening, gradually accumulating a total of three hours of active playtime. The system tracks the player's cumulative playtime across all sessions and, upon reaching the three-hour mark, triggers the Cumulative Playtime Mystery Jackpot. The player is notified of the jackpot win, receiving a reward for their long-term engagement with the casino. The event is displayed to other players, motivating them to stay active in hopes of reaching their own cumulative playtime milestone.

### Example System Procedural Flow:

1. Playtime Tracking:
   The system tracks each player's active playtime across all games and sessions, updating their cumulative playtime in real-time.
2. Threshold Check:
   The system continuously checks each player's total playtime, comparing it to the predefined threshold required to trigger the jackpot.
3. Jackpot Trigger:
   When a player reaches the required cumulative playtime (e.g., three hours), the system triggers the Mystery Jackpot.
4. Payout and Notification:
   The player is notified of the jackpot win, and the prize is credited to their account. The event is announced to encourage other players to continue playing.
5. Logging and Reset:
   The system logs the player's total playtime, the jackpot trigger, and the payout details. The cumulative playtime tracker resets for the next player.

### Noteworthy Aspects and Features:

This trigger rewards players for their long-term engagement, encouraging them to stay in the game for extended periods. The Cumulative Playtime Mystery Jackpot adds an additional layer of motivation for players, as they work toward a clear goal over multiple sessions. This feature fosters loyalty and persistence, making it an effective tool for increasing player retention and maximizing session lengths.

### Mystery Jackpot Triggering Criteria #30—High-Value Game Outcomes

### Description and Implementation:

The High-Value Game Outcomes Mystery Jackpot triggers when a player achieves a particularly valuable outcome in a game. This may include winning with a large bet or hitting a rare, high-paying combination such as a royal flush in poker, multiple 7s in blackjack, or landing on a single number in roulette with a large wager. The jackpot provides an additional reward for players who manage to secure such rare and high-value outcomes, beyond the regular game winnings.

The system monitors the value of each game outcome in real-time and identifies when a player secures one of these high-value results. It then triggers the jackpot and awards the player an additional prize on top of their game winnings. This type of jackpot may be customized based on the specific games offered at the casino, with different thresholds for each game to trigger the high-value outcome jackpot.

### Benefits to Players:

Players are encouraged to place larger bets and pursue high-risk, high-reward strategies, knowing that a significant win may also trigger a jackpot. The potential for an additional reward on top of already substantial game winnings enhances the excitement and adds motivation for players to bet more and stay in the game longer. This trigger also increases the sense of achievement when players hit valuable outcomes, as the jackpot further amplifies the value of their success.

### Benefits to Casinos:

For casinos, this trigger increases bet sizes and encourages players to take more risks, which results in higher overall revenue. The excitement generated by this jackpot also contributes to a more dynamic gaming floor, as players become more engaged in chasing high-value outcomes. Casinos may market this jackpot trigger as a feature that rewards risk-takers and high-stakes players, attracting a more competitive audience.

### Example Walk-Through Scenario:

A player at a high-stakes poker table places a large bet and is dealt a royal flush, one of the rarest and highest-value hands in the game. The system immediately detects this rare outcome and triggers the High-Value Game Outcomes Mystery Jackpot, awarding the player an additional jackpot prize on top of their poker winnings. The unexpected bonus heightens the excitement of the moment, and the other players at the table take note, realizing that high-value outcomes come with added rewards. The announcement of the jackpot win creates a buzz across the casino floor, drawing attention from other players and encouraging them to aim for their own high-value results.

### Example System Procedural Flow:

1. Outcome Monitoring:
   The system tracks all game outcomes, analyzing the value of each result based on the player's bet size and the game's payout structure.
2. High-Value Condition Check:
   The system checks if the player's outcome meets the predefined high-value criteria, such as hitting a royal flush, winning with a large bet, or securing a rare combination in a game.
3. Jackpot Trigger:
   If the outcome qualifies as a high-value result, the system triggers the Mystery Jackpot and awards the player an additional prize.
4. Payout and Notification:
   The player is notified of their jackpot win, and the prize is credited to their account. The event is announced across the casino to generate excitement.
5. Logging and Reset:
   The system logs the high-value outcome, the player's details, and the jackpot payout. The jackpot resets for the next eligible high-value game outcome.

### Noteworthy Aspects and Features:

This trigger encourages high-stakes play and rewards players for achieving rare, high-value outcomes. It adds an additional layer of excitement to the game by turning a big win into an even bigger opportunity through the activation of the Mystery Jackpot. This trigger is particularly appealing to risk-takers and high-rollers, making it a valuable tool for casinos to drive more significant bets and increase player engagement.

### Mystery Jackpot Triggering Criteria #31—Last Bet of the Session

### Description and Implementation:

The Last Bet of the Session Mystery Jackpot triggers when a player places what is recognized as their final bet of a gaming session. Whether the player decides to end the session after winning or losing, this jackpot provides an unexpected reward for players who are about to leave the game. The system detects when a player is concluding their session based on specific actions, such as cashing out or logging off from their terminal, and recognizes their last bet as eligible for the jackpot.

This trigger is particularly effective in keeping players engaged right until the end of their session, offering them an additional incentive to place a final bet before leaving. The system monitors player activity and automatically activates the jackpot once it identifies that the player's last bet has been made.

### Benefits to Players:

For players, the Last Bet of the Session jackpot adds a surprising element of excitement to the end of their gaming session. It provides an incentive to place a final bet before leaving, knowing that this bet may trigger a jackpot win. Players are also encouraged to end their session on a high note, with the potential for a significant reward just as they are about to conclude their gaming experience. The unexpected nature of this jackpot creates a memorable end to their session, motivating them to return for future games.

### Benefits to Casinos:

Casinos benefit from the increased bet volume as players are encouraged to place one last bet before ending their session. This trigger also helps retain players for longer, as the possibility of triggering a jackpot on the last bet keeps them engaged until the very end. Additionally, the Last Bet of the Session trigger may help casinos differentiate their offerings by providing a unique and rewarding experience for players who are concluding their gaming session.

### Example Walk-Through Scenario:

A player at an ETGT decides to end their blackjack session after a few rounds. Before logging off, they place one final bet, hoping to finish with a win. Unbeknownst to the player, the system recognizes this as their last bet of the session and triggers the Mystery Jackpot once the bet is placed. The player wins the jackpot, adding a surprising and exciting conclusion to their session. The system notifies the player of their win, and the event is broadcast across the casino floor, generating interest among other players who now consider placing their own last bets before leaving.

### Example System Procedural Flow:

1. Session Activity Monitoring:
   The system tracks the player's session activity, including the placement of bets and their decision to cash out or log off from their terminal.
2. Last Bet Identification:
   The system recognizes when a player places their final bet of the session based on specific actions (e.g., logging off or cashing out).
3. Jackpot Trigger:
   Once the last bet is identified, the system triggers the Mystery Jackpot and awards the player an additional prize.
4. Payout and Notification:
   The player is notified of their jackpot win, and the prize is credited to their account. The event is announced to other players to encourage them to place final bets before ending their session.
5. Logging and Reset:
   The system logs the player's session details, the last bet, and the jackpot payout. The jackpot resets for the next eligible last bet.

### Noteworthy Aspects and Features:

This trigger creates an exciting and memorable conclusion to the player's session, rewarding them for making their final bet before leaving the game. It encourages players to stay engaged until the very end, increasing the likelihood of them placing more bets before concluding their session. The Last Bet of the Session jackpot also adds a layer of surprise and excitement, making players more to return to the casino for future gaming experiences.

### Mystery Jackpot Triggering Criteria #32—Dealer Swaps

### Description and Implementation:

The Dealer Swaps Mystery Jackpot triggers when a new dealer takes over a table, either in live dealer games or in live Dealer-controlled Electronic Table Games (DETGs). This criterion is based on the transition of dealers, providing an unexpected reward for players who are present at the table during the dealer change. The system tracks when a dealer change occurs and randomly selects one or more players at the table to win the Mystery Jackpot during the swap.

In live casino environments, dealer swaps occur at regular intervals, often following a shift rotation. The system automatically detects when the new dealer takes over and activates the jackpot for players seated at the table. This feature adds an extra layer of excitement to routine dealer changes, turning them into a jackpot-triggering event.

### Benefits to Players:

Players are rewarded for staying at the table during dealer transitions, creating an incentive to remain seated and continue playing through the swap. The Dealer Swaps jackpot adds a sense of excitement to what would otherwise be a routine event, giving players an additional reason to look forward to dealer changes. This trigger also increases the overall engagement and anticipation for players, knowing that the arrival of a new dealer may result in a jackpot win.

### Benefits to Casinos:

For casinos, this trigger helps retain players during dealer swaps, reducing the number of players who leave the table during such transitions. It also increases player activity and bet volume, as players are incentivized to remain seated and continue playing in hopes of triggering the jackpot. The Dealer Swaps jackpot may also be marketed as a unique feature that differentiates the casino's live dealer games from competitors, attracting more players to the table.

### Example Walk-Through Scenario:

During a live dealer blackjack game, the current dealer finishes their shift and is replaced by a new dealer. As the swap takes place, the system randomly selects one of the players who remained seated at the table during the transition and triggers the Mystery Jackpot. The selected player wins the jackpot, receiving a prize for being present at the table during the dealer change. The announcement of the win energizes the table, encouraging other players to stay through future dealer swaps in hopes of triggering their own jackpot.

### Example System Procedural Flow:

1. Dealer Change Monitoring:
   The system tracks the dealer's activity and detects when a dealer change occurs at the table, either due to a shift rotation or another reason.
2. Player Eligibility Check:
   The system identifies the players who remained seated at the table during the dealer swap, ensuring they are eligible for the jackpot.
3. Jackpot Trigger:
   When the dealer change is complete, the system triggers the Mystery Jackpot and randomly selects one of the eligible players to receive the prize.
4. Payout and Notification:
   The selected player is notified of their jackpot win, and the prize is credited to their account. The event is announced to other players, encouraging them to stay through future dealer swaps.
5. Logging and Reset:
   The system logs the dealer swap event, the eligible players, and the jackpot payout. The jackpot resets for the next dealer change.

### Noteworthy Aspects and Features:

The Dealer Swaps jackpot turns routine dealer transitions into exciting opportunities for players, encouraging them to remain seated and continue playing during these events. This trigger enhances player retention and engagement, reducing the likelihood of players leaving the table during dealer changes. By adding a layer of excitement to dealer swaps, this feature helps keep the game lively and dynamic, benefiting both the casino and the players.

### Mystery Jackpot Triggering Criteria #33—Low-Frequency Player Reward

### Description and Implementation:

The Low-Frequency Player Reward Mystery Jackpot is designed to encourage and reward players who participate infrequently or have not visited the casino in a while. This jackpot is triggered when a player who has been inactive for an extended period (e.g., weeks or months) returns to play at an ETGT or LDGT. The system tracks player activity over time and identifies those who have been absent for a long period, rewarding them with a jackpot when they re-engage with the casino.

This trigger may be customized based on the specific inactivity period (e.g., a player who hasn't played for 30 days) and may apply across all games offered by the casino. The system automatically activates the jackpot when an eligible low-frequency player returns and places a bet, rewarding them for their renewed participation.

### Benefits to Players:

This trigger rewards players for returning to the casino after a period of inactivity, providing an unexpected incentive to re-engage with the games. Players who haven't visited the casino for a while are given a warm welcome with the potential for a jackpot win, making them feel valued and encouraging them to stay and play for longer. The Low-Frequency Player Reward also creates a memorable experience for players who may have been considering a return to the casino, offering them an additional reason to visit.

### Benefits to Casinos:

For casinos, this trigger helps to reactivate dormant players and encourage them to return for more frequent gaming sessions. By offering a jackpot for low-frequency players, casinos may foster player loyalty and incentivize them to re-engage after periods of inactivity. This trigger also provides casinos with an effective tool for player retention, as it may be marketed as a special offer to bring back infrequent players, ultimately increasing overall player activity and revenue.

### Example Walk-Through Scenario:

A player who hasn't visited the casino in over a month decides to return and play at an ETGT blackjack table.

The system recognizes the player's long period of inactivity and triggers the Low-Frequency Player Reward Mystery Jackpot as soon as the player places their first bet. The player is notified of their jackpot win, receiving a warm welcome back to the casino with a significant prize. The event is broadcast to other players, highlighting the casino's efforts to reward returning players and encouraging others to maintain their loyalty.

### Example System Procedural Flow:

1. Player Activity Monitoring:
   The system tracks the activity of all registered players, identifying those who have been inactive for an extended period (e.g., 30 days).
2. Return Visit Detection:
   When an inactive player returns and places a bet, the system detects their re-engagement with the casino.
3. Jackpot Trigger:
   Upon detecting the return of a low-frequency player, the system triggers the Mystery Jackpot, rewarding the player for their renewed participation.
4. Payout and Notification:
   The player is notified of their jackpot win, and the prize is credited to their account. The event is announced across the casino to celebrate the return of inactive players.
5. Logging and Reset:
   The system logs the player's inactivity period, the return event, and the jackpot payout. The jackpot resets for the next eligible low-frequency player.

### Noteworthy Aspects and Features:

The Low-Frequency Player Reward jackpot helps casinos reactivate dormant players by offering them an unexpected reward for their return. This trigger encourages player retention by rewarding loyalty and providing a memorable experience for players who haven't visited the casino in a while. It also helps casinos maintain long-term engagement with their player base, ensuring that even infrequent players have an incentive to return for future gaming sessions.

### Mystery Jackpot Triggering Criteria #34—Bet Multiplier Event

### Description and Implementation:

The Bet Multiplier Event Mystery Jackpot triggers when a player achieves a specific outcome that applies a multiplier to their bet, such as doubling or tripling the original wager amount. This trigger may be tied to in-game actions or features, such as landing a bonus round in a slot game, hitting a specific combination of cards in blackjack, or rolling a high-value number in craps. The system detects when the multiplier event occurs and, if the resulting winnings reach a certain threshold, the Mystery Jackpot is triggered, providing the player with an even larger reward.

In an ETGT or LDGT environment, the multiplier may be predetermined or randomized, depending on the game. The system tracks the player's bets and outcomes, applying the multiplier when triggered. If the bet multiplier event results in a high payout or meets the jackpot criteria, the system activates the jackpot, providing a surprise bonus to the player.

### Benefits to Players:

Players are incentivized by the potential for multiplied winnings, which significantly increase the excitement of placing larger bets or engaging in bonus features. The added prospect of triggering a Mystery Jackpot when a bet multiplier is applied offers an additional layer of reward, encouraging players to take risks or play longer. The possibility of multiplied payouts makes every game more thrilling, especially when combined with the opportunity for a jackpot win.

### Benefits to Casinos:

For casinos, the Bet Multiplier Event encourages players to place larger bets or engage in higher-risk gameplay, which in turn leads to higher overall wager volumes. This trigger also adds excitement and variety to games, keeping players engaged as they look forward to potential multiplier events that may result in a jackpot win. Casinos may use this feature to promote specific games or events, highlighting the chances of multiplied payouts and jackpot rewards to attract players.

### Example Walk-Through Scenario:

A player at an ETGT blackjack table is dealt two cards totaling 11 and decides to double down, placing a larger bet. The next card drawn completes a strong hand, resulting in a significant win. Since this is a bet multiplier event, the system not only doubles the player's original wager but also recognizes that the multiplier win meets the Mystery Jackpot criteria. The jackpot is triggered, and the player receives an additional payout on top of their winnings, making the event even more exciting. Other players at the table take notice, intrigued by the potential for multiplier events leading to jackpot wins.

### Example System Procedural Flow:

1. Bet Placement and Monitoring:
   The system tracks all bets placed by players, monitoring for actions that may trigger a multiplier event (e.g., doubling down in blackjack or triggering a bonus round in slots).
2. Multiplier Application:
   When the multiplier event occurs, the system calculates the increased payout based on the multiplier applied to the player's bet.
3. Jackpot Condition Check:
   The system checks if the multiplied payout meets the predefined threshold for triggering the Mystery Jackpot.
4. Jackpot Trigger:
   If the multiplied winnings qualify, the system activates the Mystery Jackpot and awards the player an additional prize.
5. Payout and Notification:
   The player is notified of the jackpot win, and the prize is credited to their account. The event is announced to other players to promote continued engagement.
6. Logging and Reset:
   The system logs the bet multiplier event, the player's winnings, and the jackpot payout. The jackpot is reset for the next eligible event.

### Noteworthy Aspects and Features:

This trigger adds an exciting dimension to standard gameplay by rewarding players with multiplied payouts and offering the chance for a jackpot on top of these enhanced winnings. It encourages players to take risks and engage in bet multiplier opportunities, knowing that the rewards may be even greater if the jackpot is triggered. The Bet Multiplier Event is especially appealing to players who enjoy high-stakes gaming and the thrill of compounded rewards.

### Mystery Jackpot Triggering Criteria #35—Player Loyalty Milestone

### Description and Implementation:

The Player Loyalty Milestone Mystery Jackpot triggers when a player reaches a specific loyalty milestone, such as accumulating a certain number of loyalty points, completing a set number of games, or achieving a particular rank within the casino's loyalty program. This trigger is designed to reward consistent play and long-term engagement, providing loyal players with an additional incentive to stay active in the casino. The system tracks each player's progress in real-time, activating the Mystery Jackpot once they hit the predefined loyalty milestone.

This jackpot may be tailored to the casino's specific loyalty program, with milestones set based on player behavior, such as total bets placed, the number of gaming sessions, or specific game achievements. The system monitors these factors and automatically triggers the jackpot when the player reaches the required loyalty milestone.

### Benefits to Players:

For players, the Player Loyalty Milestone trigger provides a clear goal to work toward, enhancing their sense of accomplishment as they accumulate points or reach new loyalty tiers. It rewards consistent play and makes players feel valued for their long-term engagement with the casino. The added prospect of a Mystery Jackpot win at notable milestones encourages players to stay active and continue building their loyalty status, making the gaming experience more rewarding.

### Benefits to Casinos:

This trigger helps casinos build player loyalty and retention by providing tangible rewards for continued engagement. By offering a jackpot for reaching loyalty milestones, casinos may encourage players to return more frequently and play for longer periods. The Player Loyalty Milestone also gives casinos an opportunity to personalize promotions and reward loyal players, fostering stronger relationships and increasing player satisfaction.

### Example Walk-Through Scenario:

A regular player at a DETG blackjack table has been steadily accumulating loyalty points through consistent gameplay. After completing their 500th gaming session, the system recognizes that the player has reached a loyalty milestone and triggers the Player Loyalty Milestone Mystery Jackpot. The player is rewarded with a substantial jackpot prize as a thank-you for their loyalty and dedication to the casino. The announcement of the win highlights the casino's commitment to rewarding its most loyal players, encouraging others to participate more actively in the loyalty program.

### Example System Procedural Flow:

1. Loyalty Tracking:
   The system tracks each player's loyalty status, including points earned, games played, or other factors contributing to loyalty milestones.
2. Milestone Achievement Check:
   The system monitors the player's progress toward predefined milestones (e.g., 500 games played or a specific number of loyalty points).
3. Jackpot Trigger:
   Once the player reaches the loyalty milestone, the system triggers the Mystery Jackpot to reward their achievement.
4. Payout and Notification:
   The player is notified of their jackpot win, and the prize is credited to their account. The win is promoted across the casino to encourage other players to participate in the loyalty program.
5. Logging and Reset:
   The system logs the player's loyalty status, milestone achieved, and jackpot payout. The milestone counter resets for the next qualifying event.

### Noteworthy Aspects and Features:

This trigger enhances the player experience by recognizing and rewarding loyalty, making players feel appreciated for their long-term engagement. It motivates players to continue building their loyalty status, knowing that they are working toward a jackpot prize. By encouraging ongoing participation, the Player Loyalty Milestone trigger helps casinos maintain player retention and increase overall activity.

### Mystery Jackpot Triggering Criteria #36—Minimum Bet Jackpot

### Description and Implementation:

The Minimum Bet Jackpot triggers when a player places a bet at or above a specific minimum wager threshold. Unlike high-stakes jackpots that reward larger bets, this criterion is designed to encourage broader participation by rewarding players for meeting the minimum bet requirement in any given game. The system tracks the value of each player's bets, ensuring that the wager meets or exceeds the minimum threshold to qualify for the jackpot.

This trigger may apply to a wide range of games, including blackjack, poker, roulette, and slots, making it accessible to a variety of players. The system recognizes when a player places a qualifying bet and, if the minimum bet condition is met during a specific game event or round, triggers the Mystery Jackpot, rewarding the player for their participation.

### Benefits to Players:

Players are motivated to place consistent bets at or above the minimum threshold, knowing that meeting this requirement gives them a chance to win a jackpot. This feature encourages players who may not usually bet large amounts to stay engaged, offering them the opportunity to win significant prizes without needing to increase their wagers substantially. The Minimum Bet Jackpot makes gameplay more inclusive, rewarding a broader spectrum of players.

### Benefits to Casinos:

For casinos, this trigger encourages more players to place qualifying bets, leading to higher bet volumes and greater participation across all games. By setting a minimum bet threshold for jackpot eligibility, casinos ensure that players are betting consistently, which may help maintain steady revenue streams. This trigger also creates a more dynamic and engaging gaming floor, as players at all levels are incentivized to continue placing qualifying bets to trigger the jackpot.

### Example Walk-Through Scenario:

A player at a roulette table places a $10 bet, which meets the casino's minimum bet threshold for jackpot eligibility. During the round, the player's number hits, and the system recognizes that their minimum qualifying bet has won. As a result, the Minimum Bet Jackpot is triggered, and the player receives an additional payout beyond their roulette winnings. The unexpected bonus rewards the player for participating in the game at the qualifying level, encouraging them to continue placing bets that meet the minimum threshold.

### Example System Procedural Flow:

1. Bet Monitoring:
   The system tracks the size of each player's bet, ensuring that it meets or exceeds the predefined minimum threshold for jackpot eligibility.
2. Condition Check:
   During each game round, the system checks if the player's bet qualifies for the jackpot based on the minimum bet requirement.
3. Jackpot Trigger:
   When a qualifying bet meets the game outcome condition, the system triggers the Mystery Jackpot, rewarding the player for placing a minimum bet.
4. Payout and Notification:
   The player is notified of their jackpot win, and the prize is credited to their account. The event is announced across the casino to promote continued participation at the qualifying bet level.
5. Logging and Reset:
   The system logs the qualifying bet, the game outcome, and the jackpot payout. The jackpot resets for the next round of qualifying minimum bets.

### Noteworthy Aspects and Features:

This trigger encourages a wide range of players to participate in jackpot opportunities, making the experience more accessible to those who prefer lower-stakes gameplay. The Minimum Bet Jackpot rewards consistent betting behavior and enhances the overall player experience by offering significant rewards for meeting straightforward wagering conditions. By promoting participation across all player levels, this trigger helps casinos increase player retention and maintain steady bet volumes.

### Mystery Jackpot Triggering Criteria #37—Game Outcome Series

### Description and Implementation:

The Game Outcome Series Mystery Jackpot triggers when a player achieves a specific series of outcomes in a row during gameplay. This may involve winning three blackjack hands consecutively, hitting the same number in roulette multiple times, or winning several poker hands in a row. The system tracks each player's results over time, recognizing when the player hits a streak of wins, losses, or other predefined outcomes in a sequence. When the series is achieved, the system activates the Mystery Jackpot.

This trigger may be customized for different games, with varying levels of difficulty for the outcome series. For example, a series of three wins in a row may trigger a smaller jackpot, while achieving five or more consecutive wins may result in a larger jackpot payout. The system continuously monitors player outcomes, ensuring that the series of results qualifies for the jackpot.

### Benefits to Players:

Players are motivated to stay engaged as they work toward achieving a specific series of outcomes that will trigger the jackpot. The thrill of potentially winning a jackpot after completing a sequence of wins keeps players focused and involved in the game. This trigger also rewards persistence, as players know that continuing to play may lead to the jackpot if they hit the required series of outcomes.

### Benefits to Casinos:

For casinos, this trigger helps increase player retention and engagement by encouraging longer play sessions. Players are more to remain active as they pursue the series of outcomes needed to trigger the jackpot, leading to higher bet volumes and extended gameplay. The Game Outcome Series jackpot may also be used as a promotional tool, highlighting specific games or streaks that offer higher rewards for consecutive outcomes, driving additional traffic to certain tables or games.

### Example Walk-Through Scenario:

At a baccarat table, a player places consistent bets on the player hand and wins three consecutive rounds. The system tracks the series of wins and recognizes that the player has met the required condition for the Game Outcome Series Mystery Jackpot. The jackpot is triggered, and the player is rewarded with an additional payout for achieving the win streak. Other players at the table take note of the event, realizing that a series of wins may lead to a similar jackpot for them.

### Example System Procedural Flow:

1. Outcome Monitoring:
   The system tracks the player's game outcomes, recording each result and identifying streaks of consecutive wins or other predefined series of outcomes.
2. Series Condition Check:
   The system checks if the player's outcomes meet the required series of results to trigger the jackpot (e.g., three consecutive wins).
3. Jackpot Trigger:
   When the player achieves the required outcome series, the system triggers the Mystery Jackpot, rewarding the player for their streak.
4. Payout and Notification:
   The player is notified of their jackpot win, and the prize is credited to their account. The win is announced to other players to encourage them to continue pursuing their own outcome series.
5. Logging and Reset:
   The system logs the player's outcome series, the jackpot trigger, and the payout details. The jackpot resets for the next qualifying series.

### Noteworthy Aspects and Features:

The Game Outcome Series jackpot rewards players for achieving a specific sequence of results, encouraging them to remain engaged in the game as they work toward completing the series. It adds excitement and a sense of accomplishment to gameplay, motivating players to stay active in hopes of hitting a winning streak or other predefined series. This trigger also benefits casinos by increasing player retention and encouraging longer play sessions, resulting in higher bet volumes and sustained engagement.

### Mystery Jackpot Triggering Criteria #38—Shared Table Event

### Description and Implementation:

The Shared Table Event Mystery Jackpot triggers when all players at a table experience a specific shared event, such as everyone winning the same round, all players betting on the same outcome, or a collective event occurring, like each player receiving a blackjack simultaneously. This type of jackpot fosters a sense of camaraderie, as it may require multiple players to achieve a common goal to trigger the reward. The system monitors each player's actions and results, and when the collective event is met, the jackpot is triggered, distributing the reward among all players at the table or awarding it to one randomly selected participant.

This trigger may be applied across various live dealer or electronic table games (ETGTs and LDGTs), such as blackjack, baccarat, or poker. The conditions for triggering the jackpot may be customized based on the game, allowing casinos to set collective milestones or outcomes that activate the jackpot.

### Benefits to Players:

Players benefit from the collaborative aspect of this trigger, as it encourages teamwork and shared excitement. Knowing that a jackpot may be triggered by a collective outcome adds a new layer of anticipation, motivating players to remain at the table and work together. The shared event enhances the social dynamics of table games, fostering a sense of community among players who may otherwise only focus on individual success. This type of jackpot creates a rewarding experience for everyone involved.

### Benefits to Casinos:

For casinos, the Shared Table Event jackpot increases player retention by encouraging all players to stay at the table, knowing that a shared event may trigger a substantial prize. This trigger enhances the overall energy and atmosphere of the gaming floor, as multiple players simultaneously experience the thrill of a jackpot. Additionally, it encourages more players to join and stay active at tables, increasing bet volume and session length, which boosts the casino's overall revenue. The communal nature of this jackpot may also be used as a marketing tool, highlighting the unique and engaging nature of the gaming experience.

### Example Walk-Through Scenario:

At a live dealer baccarat table, all five players decide to bet on the banker's hand for the current round. The cards are dealt, and the banker wins. The system recognizes this collective event and triggers the Shared Table Event Mystery Jackpot, awarding a prize to all players who participated in the round. Each player receives a share of the jackpot, creating excitement and a sense of camaraderie at the table. Other players at nearby tables observe the event and are encouraged to join, hoping to trigger similar collective jackpots through shared betting outcomes.

### Example System Procedural Flow:

1. Player Actions Monitoring:
   The system tracks each player's actions and bets in real-time, identifying when all players at the table are participating in a shared event (e.g., betting on the same outcome).
2. Shared Outcome Check:
   The system monitors the results of the round to determine if all players achieved the shared event condition (e.g., all winning the round or betting on the same outcome).
3. Jackpot Trigger:
   Once the shared event condition is met, the system triggers the Mystery Jackpot and distributes the prize among the players at the table or selects one winner randomly.
4. Payout and Notification:
   The jackpot prize is awarded, and the players are notified of their win. The event is announced across the casino to generate excitement.
5. Logging and Reset:
   The system logs the shared event, the players involved, and the jackpot payout. The jackpot resets for the next qualifying shared table event.

### Noteworthy Aspects and Features:

This trigger adds a collaborative dimension to traditional table games, rewarding players for working together to achieve a common goal. It encourages longer play sessions and enhances the social dynamics of the gaming experience, as players share in the excitement of triggering a jackpot together. The Shared Table Event jackpot is particularly effective at retaining players and boosting engagement, as the possibility of a collective win motivates them to remain at the table and participate in shared events.

### Mystery Jackpot Triggering Criteria #39—Wager Frequency Jackpot

### Description and Implementation:

The Wager Frequency Jackpot triggers when a player places a high number of bets within a specified time frame, such as 20 bets within an hour or 10 consecutive bets without a break. This jackpot rewards players for their consistency and frequent participation, encouraging rapid gameplay and sustained engagement. The system monitors each player's betting activity, and once the frequency threshold is reached, the Mystery Jackpot is triggered, providing the player with a bonus payout for their frequent wagering.

This trigger may be applied across all types of table games and ETGTs, where players place bets over multiple rounds. The threshold for wager frequency may be adjusted depending on the casino's preferences, allowing for greater flexibility in rewarding active players who consistently place bets during their gaming sessions.

### Benefits to Players:

Players are motivated to place bets more frequently, knowing that their consistent participation may lead to a jackpot. This trigger rewards players for their commitment to rapid and sustained gameplay, giving them a sense of accomplishment as they work toward meeting the wager frequency goal. The added possibility of winning a jackpot for placing frequent bets keeps players engaged, ensuring that they remain active in the game without long breaks between rounds.

### Benefits to Casinos:

For casinos, the Wager Frequency Jackpot increases bet volume and session lengths, as players are encouraged to place frequent wagers to meet the jackpot criteria. This trigger also helps maintain a steady flow of gameplay, as players remain active and avoid taking breaks to increase their chances of triggering the jackpot. By promoting frequent participation, casinos benefit from higher overall revenue and increased engagement. Additionally, this trigger may be customized to suit different games and promotional events, making it a versatile tool for boosting player activity.

### Example Walk-Through Scenario:

A player at an ETGT poker table decides to participate in rapid gameplay, placing consistent bets over multiple rounds. The system tracks the player's wager frequency and recognizes that they have placed 20 bets within a one-hour time frame, meeting the criteria for the Wager Frequency Jackpot. The jackpot is triggered, and the player receives a bonus payout for their frequent participation. The event is announced to other players, encouraging them to increase their wager frequency in hopes of triggering the same jackpot.

### Example System Procedural Flow:

1. Bet Tracking:
   The system monitors each player's betting activity, recording the number of bets placed within a specified time frame.
2. Frequency Threshold Check:
   The system checks if the player has met the wager frequency requirement (e.g., 20 bets in one hour).
3. Jackpot Trigger:
   Once the frequency threshold is reached, the system triggers the Mystery Jackpot and awards the player a prize.
4. Payout and Notification:
   The player is notified of their jackpot win, and the prize is credited to their account. The event is announced across the casino to promote rapid gameplay.
5. Logging and Reset:
   The system logs the player's wager frequency, the jackpot trigger, and the payout details. The jackpot resets for the next eligible player.

### Noteworthy Aspects and Features:

This trigger rewards rapid and frequent gameplay, encouraging players to stay engaged by placing consecutive bets. It enhances the pace of play and keeps players focused on meeting the wager frequency threshold, creating a more dynamic gaming experience. The Wager Frequency Jackpot is an effective tool for increasing bet volume and player retention, ensuring that players remain active and motivated to continue betting consistently.

### Mystery Jackpot Triggering Criteria #40—Total Winnings Threshold

### Description and Implementation:

The Total Winnings Threshold Mystery Jackpot triggers when a player's cumulative winnings reach or exceed a certain amount, such as $10,000 in one session or $50,000 over multiple sessions. This jackpot rewards players who achieve sustained success during their gaming experience, providing an additional incentive for them to continue playing and building up their total winnings. The system tracks each player's winnings in real-time and activates the jackpot once the total winnings threshold is met.

This trigger may be customized based on the specific games and player behavior, with different thresholds for various game types. It encourages players to focus on long-term success, knowing that reaching a cumulative winnings milestone may result in a jackpot payout.

### Benefits to Players:

Players benefit from the added excitement of knowing that their cumulative success may lead to a jackpot, incentivizing them to continue playing and winning. The Total Winnings Threshold jackpot rewards players for sustained performance, giving them an extra boost as they accumulate winnings over time. This trigger also provides players with a clear goal to work toward, enhancing the sense of achievement when they reach the threshold and trigger the jackpot.

### Benefits to Casinos:

For casinos, this trigger increases player retention by encouraging players to remain active and continue building up their winnings. The focus on cumulative success ensures that players are motivated to stay for longer sessions, resulting in higher overall bet volumes and more sustained gameplay. The Total Winnings Threshold jackpot also promotes a sense of accomplishment for players, making them more to return to the casino for future sessions to try and reach the next milestone.

### Example Walk-Through Scenario:

A player at a high-stakes baccarat table has been steadily winning throughout the evening. After several rounds of successful bets, the system calculates that the player's total winnings have exceeded $10,000, reaching the threshold for the Total Winnings Threshold Mystery Jackpot. The jackpot is triggered, and the player is awarded a significant prize in addition to their regular game winnings. The event is broadcast across the casino, celebrating the player's success and motivating others to pursue similar cumulative winnings.

### Example System Procedural Flow:

1. Winnings Tracking:
   The system tracks each player's cumulative winnings over the course of a session or multiple sessions, updating the total in real-time.
2. Threshold Check:
   The system checks if the player's total winnings have reached or exceeded the predefined threshold (e.g., $10,000 in one session).
3. Jackpot Trigger:
   Once the threshold is reached, the system triggers the Mystery Jackpot and awards the player a bonus prize for their cumulative success.
4. Payout and Notification:
   The player is notified of their jackpot win, and the prize is credited to their account. The event is announced to celebrate the player's achievement and promote continued gameplay.
5. Logging and Reset:
   The system logs the player's total winnings, the threshold met, and the jackpot payout. The jackpot resets for the next qualifying player.

### Noteworthy Aspects and Features:

This trigger rewards long-term success and provides players with a clear goal to work toward as they accumulate winnings. It enhances the gaming experience by celebrating cumulative achievements, motivating players to stay active and continue winning in hopes of reaching the jackpot threshold. The Total Winnings Threshold jackpot is an effective tool for increasing player retention and engagement, encouraging players to focus on sustained success over time.

### Mystery Jackpot Triggering Criteria #41—Mixed Game Participation

### Description and Implementation:

The Mixed Game Participation Mystery Jackpot triggers when a player participates in multiple different games during a single session, such as playing blackjack, roulette, and poker within the same timeframe. This trigger encourages players to diversify their gaming experience by rewarding them for trying out different games instead of focusing on just one. The system monitors the player's activity across various games, and when they meet the required participation criteria, the jackpot is triggered.

This trigger is particularly effective in ETGTs or LDGTs, where players may easily switch between different games at connected terminals. The participation threshold may be customized based on the number of games played or the type of games involved, allowing casinos to promote mixed game sessions that offer a more varied and engaging experience.

### Benefits to Players:

Players are encouraged to explore different games during their session, knowing that participating in multiple games increases their chances of triggering the jackpot. This trigger provides variety and excitement, as players are rewarded for trying new games and expanding their gaming repertoire. The Mixed Game Participation jackpot adds an element of discovery to the casino experience, making each new game a potential gateway to a jackpot win.

### Benefits to Casinos:

For casinos, this trigger helps drive engagement across multiple games, increasing overall activity and bet volumes. By encouraging players to participate in various games, casinos may distribute traffic more evenly across different tables or terminals, reducing congestion in more popular games. The Mixed Game Participation jackpot also enhances the player experience by promoting variety, keeping players entertained and motivated to explore the full range of games offered by the casino.

### Example Walk-Through Scenario:

A player starts their session by playing a few rounds of blackjack at an ETGT, then switches to a poker table, followed by a final game of roulette. The system tracks the player's activity across all three games and recognizes that they have participated in enough different games to meet the criteria for the Mixed Game Participation Mystery Jackpot. The jackpot is triggered, and the player receives a bonus payout for diversifying their gaming experience. The event is announced across the casino, encouraging other players to try out different games to trigger their own jackpot.

### Example System Procedural Flow:

1. Game Participation Monitoring:
   The system tracks the player's participation in different games during a single session, recording the number of unique games played.
2. Threshold Check:
   The system checks if the player has met the participation requirement for triggering the jackpot (e.g., playing three different games).
3. Jackpot Trigger:
   Once the participation threshold is met, the system triggers the Mystery Jackpot and rewards the player for engaging in multiple games.
4. Payout and Notification:
   The player is notified of their jackpot win, and the prize is credited to their account. The event is announced to promote mixed game participation among other players.
5. Logging and Reset:
   The system logs the player's game participation, the jackpot trigger, and the payout details. The jackpot resets for the next eligible player.

### Noteworthy Aspects and Features:

This trigger promotes variety and exploration, rewarding players for participating in multiple games within a single session. It enhances the player experience by encouraging them to try new games and adds excitement by offering a jackpot for mixed game participation. The Mixed Game Participation jackpot is an effective tool for casinos to drive engagement across various games, ensuring that players stay active and entertained throughout their session.

### Mystery Jackpot Triggering Criteria #42—Jackpot Contribution by all Players

### Description and Implementation:

The Jackpot Contribution by All Players Mystery Jackpot is triggered when every player at the table or participating ETGTs places a side bet that contributes to a shared jackpot pool during the same game round. This trigger incentivizes collective participation in the jackpot, ensuring that all players are actively involved in contributing to the prize pool. The system monitors each player's side bets in real-time, and once all players at the table have placed their contribution, the Mystery Jackpot is triggered, either awarding the entire pool to one player or distributing it equally among the contributors.

This trigger is applicable across various games such as baccarat, poker, and blackjack, and may be customized to fit the specific dynamics of the game. It encourages collaboration among players, as everyone must contribute for the jackpot to be triggered.

### Benefits to Players:

Players are motivated by the prospect of a collective win, knowing that their participation in the side bet increases the overall jackpot pool and their chances of receiving a significant payout. This trigger fosters a sense of community, as players encourage each other to contribute to the jackpot, making the gaming experience more social and engaging. The excitement of knowing that everyone at the table is working toward a common goal adds an extra layer of anticipation to each game round.

Benefits to Casinos:

For casinos, this trigger increases the total number of side bets placed, which directly contributes to higher overall revenue. By encouraging all players to participate in the jackpot contribution, casinos benefit from more consistent and frequent side bets across the gaming floor. Additionally, this trigger enhances player retention, as the collective nature of the jackpot encourages players to stay at the table longer and continue contributing to the pool. The collaborative aspect of this trigger may also serve as a marketing tool to attract players who enjoy shared gaming experiences.

### Example Walk-Through Scenario:

At a live dealer poker table, each player has the option to place a $5 side bet that contributes to a shared jackpot pool. During one round, all six players at the table decide to place their side bets, meeting the criteria for the Jackpot Contribution by All Players trigger. The system detects that everyone has contributed, and the Mystery Jackpot is activated. The pool is awarded to one randomly selected player, who receives a substantial prize. The excitement of the collective win keeps the other players engaged, and they eagerly place side bets in the following rounds, hoping to trigger the jackpot again.

### Example System Procedural Flow:

1. Side Bet Monitoring:
   The system tracks all side bets placed by players in real-time, monitoring whether every player at the table has made a qualifying contribution to the jackpot pool.
2. Contribution Condition Check:
   The system checks if all players have placed a side bet during the same game round, ensuring that the collective contribution condition is met.
3. Jackpot Trigger:
   Once all players have contributed, the system triggers the Mystery Jackpot, randomly selecting a winner or distributing the pool evenly among the players.
4. Payout and Notification:
   The winning player(s) are notified, and the prize is credited to their account. The event is announced across the casino to promote collective side betting.
5. Logging and Reset:
   The system logs the side bet contributions, the jackpot trigger, and the payout details. The jackpot pool resets for the next round of contributions.

### Noteworthy Aspects and Features:

This trigger encourages collective action and participation among players, rewarding those who contribute to the shared jackpot pool. It enhances the social dynamic of table games by promoting collaboration and creating a sense of community, where players work together to trigger a jackpot. The Jackpot Contribution by All Players trigger also increases bet volume and player engagement, making it a valuable tool for casinos seeking to promote sustained participation and maximize revenue.

### Mystery Jackpot Triggering Criteria #43—Dealer Achieves a Rare Event

### Description and Implementation:

The Dealer Achieves a Rare Event Mystery Jackpot triggers when the dealer experiences a highly uncommon outcome, such as dealing themselves a perfect blackjack in back-to-back rounds, hitting a specific sequence of cards, or achieving an unusually high score in a game. This trigger introduces an exciting twist by involving the dealer's performance, adding an element of unpredictability and excitement for players, who benefit from the dealer's success.

The system tracks the dealer's actions and outcomes during each round and identifies when they achieve a rare event. The Mystery Jackpot is triggered when the dealer's performance meets the predefined rare event criteria. This trigger adds a dynamic layer to gameplay, as players not only focus on their own outcomes but also eagerly watch for the dealer to achieve the jackpot-qualifying event.

### Benefits to Players:

Players are engaged by the unexpected nature of this trigger, as it adds excitement to each round, knowing that the dealer's actions may result in a jackpot win. Even if a player is not performing well, they remain invested in the game, hoping that the dealer's rare achievement will trigger a jackpot for the table. This trigger also fosters a sense of shared anticipation among players, creating excitement when they witness the dealer achieving a rare event.

### Benefits to Casinos:

For casinos, the Dealer Achieves a Rare Event jackpot keeps players engaged even during rounds when their personal outcomes may not be favorable. By tying the jackpot to the dealer's performance, casinos may retain players at the table for longer periods, increasing bet volumes and session times. The unpredictability of this trigger also adds to the overall excitement on the gaming floor, drawing in new players who are eager to experience a jackpot triggered by the dealer's rare achievement.

### Example Walk-Through Scenario:

During a live blackjack game, the dealer deals themselves a perfect 21 on two consecutive rounds—an extremely rare event. The system recognizes this unusual outcome and triggers the Dealer Achieves a Rare Event Mystery Jackpot. All players at the table are rewarded with a share of the jackpot for witnessing the dealer's rare performance. The unexpected win generates excitement at the table, encouraging other players to remain engaged in hopes of seeing the dealer trigger another jackpot with a rare achievement.

### Example System Procedural Flow:

1. Dealer Performance Monitoring:
   The system tracks the dealer's actions and outcomes during each round, recording any rare events that meet the jackpot-triggering criteria.
2. Rare Event Condition Check:
   The system checks if the dealer's performance matches the predefined rare event condition (e.g., dealing consecutive perfect hands).
3. Jackpot Trigger:
   When the dealer achieves the rare event, the system triggers the Mystery Jackpot, rewarding the players at the table.
4. Payout and Notification:
   The jackpot prize is distributed among the players, and they are notified of their win. The event is announced across the casino to promote excitement.
5. Logging and Reset:
   The system logs the dealer's rare event, the players involved, and the jackpot payout. The jackpot resets for the next qualifying dealer event.

### Noteworthy Aspects and Features:

This trigger adds an unpredictable and exciting element to gameplay by rewarding players for the dealer's rare achievements. It keeps players engaged in every round, even when their personal outcomes are not favorable, and fosters a shared sense of anticipation at the table. The Dealer Achieves a Rare Event jackpot increases player retention and adds excitement to the gaming floor, enhancing the overall casino experience.

### Mystery Jackpot Triggering Criteria #44—Tournament Winner Jackpot

### Description and Implementation:

The Tournament Winner Jackpot triggers when a player wins a casino-hosted tournament, such as a poker, blackjack, or roulette competition. This jackpot provides an additional reward for players who achieve first place in a tournament, offering them a bonus payout beyond the standard tournament prize pool. The system tracks the progress of each tournament and activates the Mystery Jackpot for the winner once the event concludes.

This trigger is designed to enhance the excitement of competitive play, rewarding players who perform well in casino-sponsored tournaments. It may be applied across various types of tournaments, with the jackpot amount varying based on the size of the event or the number of participants.

### Benefits to Players:

For players, the Tournament Winner Jackpot offers an extra layer of motivation to compete in casino-hosted tournaments. In addition to the standard prize pool, players have the opportunity to win a significant jackpot for securing first place. This added incentive drives competitive spirit and encourages players to participate in more tournaments, knowing that a jackpot reward is on the line. The thrill of competing for both the tournament prize and the jackpot enhances the overall excitement of the event.

### Benefits to Casinos:

For casinos, the Tournament Winner Jackpot helps increase participation in competitive events, as players are motivated by the prospect of winning both the tournament and the jackpot. This trigger boosts tournament attendance, resulting in larger prize pools and higher entry fees, which in turn increase the casino's overall revenue. Additionally, the promise of a jackpot for tournament winners helps to promote the casino's tournaments, attracting a wider range of players and creating more buzz around the events.

### Example Walk-Through Scenario:

A player enters a blackjack tournament at the casino and, after a series of rounds, emerges as the winner. In addition to receiving the tournament's first-place prize, the system triggers the Tournament Winner Jackpot, awarding the player an additional bonus for their victory. The combined prize generates excitement throughout the casino, and the announcement of the jackpot win encourages other players to sign up for future tournaments in hopes of achieving similar success.

### Example System Procedural Flow:

1. Tournament Progress Monitoring:
   The system tracks the progress of the tournament, monitoring each player's performance and recording the results of each round.
2. Winner Identification:
   Once the tournament concludes, the system identifies the first-place winner based on the final results.
3. Jackpot Trigger:
   The system triggers the Mystery Jackpot for the tournament winner, awarding them a bonus prize in addition to the tournament prize pool.
4. Payout and Notification:
   The winner is notified of their jackpot win, and the prize is credited to their account. The event is announced across the casino to promote future tournaments.
5. Logging and Reset:
   The system logs the tournament results, the winner's details, and the jackpot payout. The jackpot resets for the next tournament event.

### Noteworthy Aspects and Features:

This trigger enhances the competitive atmosphere of casino tournaments by offering a substantial jackpot to the winner, motivating more players to participate. It adds excitement to the tournament experience, as players compete for both the standard prize pool and the additional jackpot reward. The Tournament Winner Jackpot also helps casinos boost tournament attendance and promote future events, increasing engagement and revenue through competitive play.

### Mystery Jackpot Triggering Criteria #45—Player Surpasses a Betting Limit

### Description and Implementation:

The Player Surpasses a Betting Limit Mystery Jackpot triggers when a player exceeds a predefined betting threshold, such as placing a bet that surpasses $1,000 in a single round. This jackpot rewards high-stakes players for taking significant risks, providing them with a bonus payout for their willingness to place large bets. The system monitors the value of each bet placed and activates the jackpot when a player meets or exceeds the betting limit.

This trigger may be customized to suit different games and player behaviors, allowing casinos to set various betting thresholds based on the game type or the player's activity. It encourages players to engage in high-stakes play by offering an additional incentive for surpassing a certain betting limit.

### Benefits to Players:

For players, this trigger adds excitement to high-stakes gameplay, as they know that surpassing a betting limit may result in a jackpot win. The potential for an extra reward encourages players to place larger bets, adding an element of risk and reward to their gaming strategy. High-rollers, in particular, are motivated by the possibility of triggering a jackpot simply by meeting the betting threshold, making their gaming experience more thrilling and rewarding.

### Benefits to Casinos:

For casinos, the Player Surpasses a Betting Limit jackpot increases the average bet size, boosting overall revenue as more players engage in high-stakes play. By setting a betting limit that triggers the jackpot, casinos encourage risk-taking behavior, which leads to larger bets and higher stakes at the table. This trigger also helps retain high-stakes players by offering them an additional incentive for placing larger bets, making them more to stay engaged and continue betting at higher levels.

### Example Walk-Through Scenario:

A player at a roulette table places a bet of $1,500 on a single number, surpassing the casino's predefined betting threshold of $1,000. The system detects that the player's bet has exceeded the limit and triggers the Player Surpasses a Betting Limit Mystery Jackpot. The player wins the jackpot in addition to their roulette payout, creating a thrilling high-stakes experience. The announcement of the jackpot win encourages other players to place larger bets, hoping to trigger their own jackpot by surpassing the betting limit.

### Example System Procedural Flow:

1. Bet Monitoring:
   The system tracks each player's bet in real-time, recording the value of the wagers placed during each round.
2. Betting Limit Check:
   The system checks if the player's bet meets or exceeds the predefined betting limit (e.g., $1,000).
3. Jackpot Trigger:
   Once the betting limit is surpassed, the system triggers the Mystery Jackpot, rewarding the player for placing a high-stakes bet.
4. Payout and Notification:
   The player is notified of their jackpot win, and the prize is credited to their account. The event is announced across the casino to promote high-stakes play.
5. Logging and Reset:
   The system logs the bet amount, the jackpot trigger, and the payout details. The jackpot resets for the next qualifying high-stakes bet.

### Noteworthy Aspects and Features:

This trigger incentivizes high-stakes gameplay by offering an additional reward for players who surpass a betting limit. It encourages players to take risks and engage in larger bets, knowing that their high-stakes wagers may trigger a jackpot. The Player Surpasses a Betting Limit jackpot is an effective tool for increasing average bet size and maintaining engagement among high-rollers, while also boosting overall casino revenue.

### Mystery Jackpot Triggering Criteria #46—Quick Decision Bonus

### Description and Implementation:

The Quick Decision Bonus Mystery Jackpot is triggered when a player makes an in-game decision within a specific time frame, such as choosing to hit, stand, or place a bet within five seconds during a round of blackjack or poker. This trigger rewards players for quick thinking and fast-paced gameplay, encouraging them to stay engaged and make decisions rapidly. The system monitors the time taken by players to make their decisions, and when a player consistently responds within the required time limit, the jackpot is triggered.

This criterion may be applied to a variety of games, including blackjack, baccarat, roulette, and poker. The casino may adjust the time limit to suit the pace of the game or the specific round, ensuring that the Quick Decision Bonus adds excitement without rushing players unnecessarily. The system automatically detects when a player meets the time criteria and activates the jackpot to reward their promptness.

### Benefits to Players:

Players enjoy the thrill of being rewarded for their quick reflexes and decision-making skills. The Quick Decision Bonus introduces a sense of urgency and excitement, motivating players to remain focused and engaged during each round. By offering a jackpot for rapid decisions, the game becomes more interactive and dynamic, keeping players on their toes and enhancing the overall gaming experience. Additionally, players who are confident in their decision-making skills are incentivized to act swiftly, knowing that their speed may lead to a significant jackpot win.

### Benefits to Casinos:

For casinos, the Quick Decision Bonus helps maintain the pace of the game, reducing downtime between rounds and ensuring that players remain actively engaged. Faster gameplay increases the number of rounds played within a session, leading to more frequent bets and higher overall revenue. This trigger also helps attract players who enjoy fast-paced gaming experiences, creating a competitive atmosphere where quick decisions are rewarded. Additionally, the Quick Decision Bonus may be marketed as a unique feature that adds an extra layer of excitement to traditional table games.

### Example Walk-Through Scenario:

During a live blackjack game, the dealer asks a player whether they want to hit or stand. The player quickly decides to hit, making their decision within three seconds. The system detects the fast response and tracks the player's decision-making time over the next few rounds. After several consecutive quick decisions, the system triggers the Quick Decision Bonus Mystery Jackpot, awarding the player a prize for their fast gameplay. The event is announced to other players, encouraging them to act swiftly in hopes of triggering their own jackpot.

### Example System Procedural Flow:

1. Decision Time Monitoring:
   The system tracks each player's decision-making time in real-time, recording how long it takes them to make their in-game choices (e.g., hit, stand, place a bet).
2. Time Limit Check:
   The system checks if the player's decisions are made within the predefined time frame (e.g., five seconds).
3. Jackpot Trigger:
   Once the player consistently meets the quick decision threshold, the system triggers the Mystery Jackpot, rewarding the player for their fast responses.
4. Payout and Notification:
   The player is notified of their jackpot win, and the prize is credited to their account. The event is announced across the casino to promote fast-paced gameplay.
5. Logging and Reset:
   The system logs the player's decision times, the jackpot trigger, and the payout details. The jackpot resets for the next eligible quick decision.

### Noteworthy Aspects and Features:

This trigger enhances the pace and excitement of the game by rewarding players for making fast decisions. It encourages quick thinking and active participation, creating a dynamic environment where players are motivated to stay engaged. The Quick Decision Bonus adds an element of competitiveness to the game, driving player retention and increasing the number of rounds played within a session, benefiting both the casino and the players.

### Mystery Jackpot Triggering Criteria #47—Double Win Streak Across Different Games

### Description and Implementation:

The Double Win Streak Across Different Games Mystery Jackpot triggers when a player wins consecutive rounds in two different games during the same session. For example, a player may win two hands in blackjack and then immediately win two rounds of poker. This jackpot rewards players for achieving consecutive success across multiple games, encouraging them to diversify their gameplay and try their luck in different types of table games or ETGTs.

The system tracks the player's progress across various games and identifies when they achieve the required double win streak. Once the streak is detected, the system triggers the Mystery Jackpot, rewarding the player for their ability to succeed in multiple games during the same session. This trigger may be customized to apply to different combinations of games, such as winning in blackjack and then roulette, or baccarat and poker.

### Benefits to Players:

Players are motivated to explore different games, knowing that success in multiple games may lead to a jackpot win. This trigger adds variety to their gaming experience, encouraging them to try new games and challenge themselves to achieve consecutive wins across different tables or terminals. The Double Win Streak jackpot rewards versatility and adaptability, making players feel accomplished for excelling in more than one game. This added incentive also keeps players engaged for longer, as they work to achieve the required streak.

### Benefits to Casinos:

For casinos, this trigger helps distribute player activity across multiple games, ensuring that different tables or terminals receive consistent traffic. By encouraging players to participate in more than one game, the casino increases bet volumes and overall engagement across the gaming floor. The Double Win Streak jackpot also promotes longer session times, as players remain active in hopes of achieving consecutive wins in different games. Additionally, this trigger may be used to highlight and promote less popular games, driving interest and participation in a broader range of offerings.

### Example Walk-Through Scenario:

A player begins their session by winning two consecutive hands in blackjack. Feeling confident, they move to a nearby poker table and win two rounds in a row. The system tracks the player's progress and recognizes that they have achieved the required double win streak across two different games. The Double Win Streak Mystery Jackpot is triggered, and the player receives a bonus prize in addition to their regular game winnings. Other players take note of the event, inspired to try their luck in different games to trigger the same jackpot.

### Example System Procedural Flow:

1. Game Participation Monitoring:
   The system tracks the player's participation in multiple games, recording the outcomes of each round across different tables or terminals.
2. Win Streak Condition Check:
   The system checks if the player has achieved consecutive wins in two different games, ensuring that the double win streak criteria are met.
3. Jackpot Trigger:
   Once the player meets the win streak condition across different games, the system triggers the Mystery Jackpot, awarding the player for their consecutive success.
4. Payout and Notification:
   The player is notified of their jackpot win, and the prize is credited to their account. The event is announced across the casino to promote mixed game participation.
5. Logging and Reset:
   The system logs the player's double win streak, the jackpot trigger, and the payout details. The jackpot resets for the next eligible streak.

### Noteworthy Aspects and Features:

This trigger encourages players to diversify their gameplay, rewarding them for achieving consecutive wins in different games. It enhances the gaming experience by motivating players to try new games and challenge themselves to succeed across multiple tables. The Double Win Streak jackpot promotes longer play sessions and increased participation across various games, benefiting both the players and the casino.

### Mystery Jackpot Triggering Criteria #48—Lucky Bet Jackpot

### Description and Implementation:

The Lucky Bet Jackpot is triggered when a player places a bet on an outcome with particularly long odds, such as betting on a single number in roulette or hitting a royal flush in poker, and that bet results in a win. This jackpot rewards players for taking high-risk bets, offering them a significant bonus payout in addition to their regular game winnings. The system tracks the odds of each bet placed, and when a player wins with an unlikely or risky bet, the Mystery Jackpot is triggered.

This trigger may be applied across multiple games, including roulette, poker, blackjack, and baccarat. Casinos may set the parameters for what constitutes a “lucky bet” based on the odds of specific outcomes in each game. The Lucky Bet Jackpot adds an extra layer of excitement for players who enjoy making bold wagers, as it rewards them for taking risks that pay off.

### Benefits to Players:

Players are incentivized to take bigger risks, knowing that their daring bets may lead to a substantial jackpot win. The Lucky Bet Jackpot adds excitement and unpredictability to each round, as players have the opportunity to win big by betting on high-risk outcomes. This trigger also rewards bold gameplay, making players feel more accomplished when their risky bets result in not only regular winnings but also a jackpot prize. The potential for a Lucky Bet Jackpot win keeps players engaged and motivated to place more daring wagers.

### Benefits to Casinos:

For casinos, the Lucky Bet Jackpot encourages riskier betting behavior, leading to higher bet volumes and larger individual wagers. By rewarding players for betting on long-odds outcomes, casinos increase the excitement and intensity of the gaming floor, attracting players who enjoy high-stakes and high-reward scenarios. This trigger also helps extend player sessions, as the possibility of winning a jackpot for a risky bet motivates players to continue making bold wagers. Additionally, the Lucky Bet Jackpot may be used to promote games with a wider range of betting options, encouraging players to explore different types of wagers.

### Example Walk-Through Scenario:

A player at a roulette table places a bet on the number 17, a long-odds wager with a high payout. When the wheel spins and the ball lands on 17, the system detects that the player has won with a high-risk bet. The Lucky Bet Jackpot is triggered, and the player receives a substantial bonus in addition to their roulette winnings. The event is announced to other players, generating excitement and inspiring them to place their own bold bets in hopes of triggering the same jackpot.

### Example System Procedural Flow:

1. Bet Tracking:
   The system tracks all bets placed by players, analyzing the odds of each wager based on the game's rules and payout structure.
2. Lucky Bet Condition Check:
   The system checks if the player's bet qualifies as a “lucky bet” based on its odds and the outcome of the round.
3. Jackpot Trigger:
   When the player wins with a lucky bet, the system triggers the Mystery Jackpot, rewarding the player for their bold wager.
4. Payout and Notification:
   The player is notified of their jackpot win, and the prize is credited to their account. The event is announced across the casino to promote risk-taking behavior.
5. Logging and Reset:
   The system logs the lucky bet, the game outcome, and the jackpot payout. The jackpot resets for the next qualifying lucky bet.

### Noteworthy Aspects and Features:

This trigger rewards players for taking high-risk, high-reward bets, adding excitement to the gaming experience by turning bold wagers into jackpot opportunities. The Lucky Bet Jackpot encourages players to take more risks, leading to higher bet volumes and extended play sessions. By promoting daring gameplay, this trigger helps casinos increase revenue while providing players with thrilling and unpredictable gaming experiences.

### Mystery Jackpot Triggering Criteria #49—Consecutive Losses Reward

### Description and Implementation:

The Consecutive Losses Reward Mystery Jackpot triggers when a player experiences a streak of consecutive losses, such as losing five rounds in a row at a blackjack table or repeatedly missing the winning number in roulette. This jackpot serves as a consolation prize for players who have been unlucky, offering them a bonus payout to soften the blow of their losing streak. The system tracks each player's results and activates the jackpot once the required number of consecutive losses is met.

This trigger may be applied to various games, including blackjack, poker, roulette, and baccarat. The casino may adjust the criteria for what constitutes a losing streak, making the jackpot accessible to players who have had a run of bad luck. The Consecutive Losses Reward encourages players to remain engaged, even when they are not winning, by providing them with a potential reward for their persistence.

### Benefits to Players:

Players who are experiencing a losing streak are given a reason to continue playing, knowing that their bad luck may eventually trigger a jackpot win. The Consecutive Losses Reward helps ease the frustration of repeated losses, offering players a consolation prize for their persistence. This trigger keeps players motivated, as they realize that even a series of losses may lead to a jackpot, making their overall gaming experience more enjoyable and less discouraging.

### Benefits to Casinos:

For casinos, the Consecutive Losses Reward helps retain players who may otherwise leave the game due to frustration after a losing streak. By offering a jackpot for consecutive losses, casinos may keep players engaged and motivated to continue playing, even when their outcomes are not favorable. This trigger also encourages longer sessions, as players are more to stay active in hopes of triggering the jackpot after a series of losses. Additionally, the Consecutive Losses Reward may be marketed as a unique feature that differentiates the casino's offerings, attracting players who appreciate the potential for a consolation jackpot.

### Example Walk-Through Scenario:

A player at a poker table experiences a streak of bad luck, losing five consecutive hands. The system tracks the player's results and recognizes that they have met the criteria for the Consecutive Losses Reward. The Mystery Jackpot is triggered, and the player is awarded a bonus prize, softening the impact of their losing streak. The event is announced to other players, providing encouragement to those who are also experiencing losing streaks and motivating them to continue playing in hopes of triggering the same reward.

### Example System Procedural Flow:

1. Loss Streak Monitoring:
   The system tracks each player's results, recording consecutive losses during their gaming session.
2. Loss Streak Condition Check:
   The system checks if the player has met the required number of consecutive losses to trigger the jackpot.
3. Jackpot Trigger:
   Once the loss streak threshold is reached, the system triggers the Mystery Jackpot, awarding the player a consolation prize for their persistence.
4. Payout and Notification:
   The player is notified of their jackpot win, and the prize is credited to their account. The event is announced to other players to promote continued engagement.
5. Logging and Reset:
   The system logs the player's loss streak, the jackpot trigger, and the payout details. The jackpot resets for the next qualifying losing streak.

### Noteworthy Aspects and Features:

This trigger provides players with a reward for enduring a losing streak, helping to alleviate the frustration of repeated losses. It encourages players to stay engaged and continue playing, even when their luck is not favorable, by offering the potential for a jackpot win after consecutive losses. The Consecutive Losses Reward helps casinos retain players during difficult gaming sessions, leading to longer playtimes and higher overall engagement.

### Mystery Jackpot Triggering Criteria #50—First Bet of the Session Jackpot

### Description and Implementation:

The First Bet of the Session Jackpot triggers when a player places their very first bet of a gaming session. This jackpot rewards players for starting their session, offering an immediate incentive for participation. As soon as a player logs into a terminal or sits down at a live dealer game table, the system tracks their first bet and, if the criteria are met, triggers the Mystery Jackpot. This type of trigger encourages players to dive into gameplay quickly and adds an extra layer of excitement from the very start of their session.

The implementation of this trigger may be customized for different games, allowing casinos to offer the First Bet of the Session Jackpot across a variety of platforms, including blackjack, poker, roulette, and baccarat. The criteria may be based on the size of the first bet, the game type, or other factors that make the jackpot more exclusive or easily accessible, depending on the casino's promotional strategy.

### Benefits to Players:

Players are rewarded right at the start of their session, creating an exciting and welcoming atmosphere. This trigger incentivizes them to engage with the game immediately, knowing that their very first action may result in a jackpot. The possibility of triggering a jackpot on the first bet also adds an element of surprise, setting a positive tone for the rest of the session. Even players who may not initially plan on placing large bets are motivated to do so in hopes of triggering the jackpot early.

### Benefits to Casinos:

For casinos, the First Bet of the Session Jackpot encourages early engagement, driving players to place their initial bets quickly and stay for longer sessions. It helps increase the frequency and volume of first-time bets across different games, contributing to higher overall revenue. This trigger also fosters positive player experiences from the outset, encouraging players to stay longer, return more frequently, and optionally bet larger amounts. Casinos may use this feature as part of a promotion to attract new players and incentivize returning players to get started with their session as soon as possible.

### Example Walk-Through Scenario:

A player logs into an ETGT poker terminal and places a $50 bet on their first hand. As soon as the bet is placed, the system recognizes this as the player's first bet of the session. The First Bet of the Session Jackpot is triggered, and the player is awarded a bonus prize immediately after placing the bet. This instant reward creates excitement for the player, who feels motivated to continue playing, knowing that their first bet resulted in a jackpot win. Other players nearby hear the announcement and quickly place their first bets, hoping to trigger the same jackpot.

### Example System Procedural Flow:

1. Session Start Monitoring:
   The system tracks when a player logs into an ETGT or sits down at a live dealer game, identifying the start of their gaming session.
2. First Bet Condition Check:
   The system monitors the player's first bet during their session, ensuring it meets any predefined criteria (e.g., minimum bet amount or game type).
3. Jackpot Trigger:
   If the conditions are met, the system triggers the First Bet of the Session Jackpot, rewarding the player for their initial wager.
4. Payout and Notification:
   The player is notified of their jackpot win, and the prize is credited to their account. The event is announced across the casino, encouraging other players to get started.
5. Logging and Reset:
   The system logs the player's first bet, the jackpot trigger, and the payout details. The jackpot resets for the next eligible first bet.

### Noteworthy Aspects and Features:

This trigger rewards players for starting their session, creating immediate excitement and engagement. It encourages players to place their first bet quickly, reducing downtime and increasing overall participation. The First Bet of the Session Jackpot is a powerful tool for driving early engagement and retention, making players more to stay active and invested in their gaming session.

### Mystery Jackpot Triggering Criteria #51—Same Game, Same Bet Jackpot

### Description and Implementation:

The Same Game, Same Bet Mystery Jackpot triggers when a player consistently places the same bet in consecutive rounds of the same game. For example, a player may continuously bet on the “player” hand in baccarat or repeatedly bet on red in roulette. This trigger rewards players for their consistency, offering a jackpot for sticking with the same bet and game across multiple rounds. The system monitors the player's betting pattern and activates the jackpot when they meet the criteria for consecutive same bets.

This trigger may be applied to various games, including blackjack, baccarat, roulette, and poker. Casinos may set the conditions for the number of consecutive rounds required to trigger the jackpot, ensuring that players must maintain their bet consistency for a predefined number of rounds. This adds an element of strategy to the game, as players may feel encouraged to stick with a specific bet in hopes of triggering the jackpot.

### Benefits to Players:

Players are rewarded for their loyalty to a specific bet, adding a new layer of excitement to repetitive gameplay. The Same Game, Same Bet jackpot incentivizes consistency and patience, providing a tangible reward for players who choose to stick with the same betting strategy. This trigger also makes each round more thrilling, as players know that their commitment to a particular bet may result in a jackpot, even if the bet itself does not win in every round. It encourages a focused and deliberate approach to the game, rewarding persistence and consistency.

### Benefits to Casinos:

For casinos, this trigger helps increase player retention by encouraging them to stay engaged for multiple rounds in the same game. Players are more to continue betting if they believe that sticking to a consistent strategy may lead to a jackpot win. The Same Game, Same Bet jackpot also promotes longer sessions, as players stay active in hopes of triggering the reward. Casinos may use this trigger to highlight specific games and drive increased participation in games where consistent betting behavior is common.

### Example Walk-Through Scenario:

A player at a roulette table decides to bet on red for several consecutive rounds. After placing the same bet for five rounds in a row, the system detects the consistency of the player's wagers and triggers the Same Game, Same Bet Mystery Jackpot. The player receives a bonus payout for their commitment to the same bet, in addition to their regular roulette winnings. The event is announced across the casino, drawing attention to the player's win and encouraging others to maintain consistent bets in hopes of triggering a similar jackpot.

### Example System Procedural Flow:

1. Betting Pattern Monitoring:
   The system tracks the player's bets in real-time, recording whether they place the same bet in consecutive rounds of the same game.
2. Consistency Check:
   The system checks if the player has consistently placed the same bet for the required number of consecutive rounds.
3. Jackpot Trigger:
   Once the consistency condition is met, the system triggers the Mystery Jackpot, rewarding the player for their commitment to the same bet.
4. Payout and Notification:
   The player is notified of their jackpot win, and the prize is credited to their account. The event is announced to encourage others to maintain consistent betting patterns.
5. Logging and Reset:
   The system logs the player's consistent betting behavior, the jackpot trigger, and the payout details.

The jackpot resets for the next eligible betting streak.

### Noteworthy Aspects and Features:

This trigger rewards players for maintaining consistent betting patterns, adding excitement and anticipation to every round. It encourages longer play sessions and promotes a strategic approach to betting, as players aim to meet the consistency threshold for the jackpot. The Same Game, Same Bet jackpot is an effective tool for keeping players engaged, ensuring that they remain invested in the outcome of each round.

### Mystery Jackpot Triggering Criteria #52—Side Bet Activation Jackpot

### Description and Implementation:

The Side Bet Activation Mystery Jackpot is triggered when a player places a side bet in a game, such as a “perfect pair” bet in blackjack or a progressive bet in poker, and that side bet results in a win. This jackpot rewards players for engaging with optional side bets, offering a significant payout in addition to the regular winnings from the side bet itself. The system tracks all side bets placed during the game, and when a player wins on one of these side bets, the Mystery Jackpot is triggered.

This trigger may be applied to various games where side bets are available, including blackjack, poker, and baccarat. Casinos may promote the Side Bet Activation Jackpot as a way to increase player engagement with side bets, driving additional revenue while adding an extra layer of excitement to each game.

### Benefits to Players:

Players are motivated to place side bets, knowing that a win may result in not only the standard payout but also a jackpot prize. This trigger adds excitement to optional side wagers, making players feel that they have a greater chance of winning something significant when engaging with side bets. The Side Bet Activation Jackpot also encourages players to experiment with different betting strategies, giving them more reasons to participate in side bets that may otherwise be overlooked.

### Benefits to Casinos:

For casinos, the Side Bet Activation Jackpot increases side bet participation, leading to higher bet volumes and overall revenue. By promoting side bets with the added possibility of a jackpot, casinos may drive more engagement across various table games. The trigger also encourages players to stay longer at the table, as they are motivated to place side bets in hopes of winning both the standard payout and the jackpot. Additionally, the Side Bet Activation Jackpot helps differentiate the casino's offerings, making side bets a more attractive option for players.

### Example Walk-Through Scenario:

A player at a blackjack table places a $10 side bet on the “perfect pair” option, in addition to their regular bet. When the cards are dealt, the player receives two matching cards, winning the side bet. The system detects the win and triggers the Side Bet Activation Mystery Jackpot, awarding the player a bonus prize in addition to their side bet winnings. The event is announced across the casino, encouraging other players to place side bets in hopes of triggering the same jackpot.

### Example System Procedural Flow:

1. Side Bet Tracking:
   The system monitors all side bets placed during the game, recording the type and value of each bet.
2. Side Bet Win Condition Check:
   The system checks if the player has won their side bet, ensuring that the side bet meets the criteria for triggering the jackpot.
3. Jackpot Trigger:
   Once the side bet win is confirmed, the system triggers the Mystery Jackpot, rewarding the player for their successful side wager.
4. Payout and Notification:
   The player is notified of their jackpot win, and the prize is credited to their account. The event is announced to promote side bet participation among other players.
5. Logging and Reset:
   The system logs the side bet win, the jackpot trigger, and the payout details. The jackpot resets for the next eligible side bet.

### Noteworthy Aspects and Features:

This trigger enhances player engagement with side bets by offering an additional reward for winning these optional wagers. It encourages players to place side bets more frequently, knowing that a win may result in both the standard payout and a jackpot. The Side Bet Activation Jackpot increases player retention and bet volume, making side bets a more integral part of the gaming experience.

### Mystery Jackpot Triggering Criteria #53—all Players Lose Event

### Description and Implementation:

The All Players Lose Event Mystery Jackpot is triggered when all players at a table or participating terminals lose the same round. This jackpot adds a surprising twist to the game by rewarding players even when everyone experiences a loss, turning a typically negative outcome into a positive one. The system monitors each player's results during the round, and if all players lose, the jackpot is triggered, distributing a prize among the losing players.

This trigger may be applied to various games such as blackjack, poker, or baccarat. It encourages players to stay engaged even when they are not winning, as a shared loss may still result in a jackpot. The All Players Lose Event jackpot helps maintain excitement and engagement, even during rounds where the outcomes are unfavorable for all participants.

### Benefits to Players:

Players benefit from this trigger by receiving a consolation prize when everyone loses, making even a negative outcome more enjoyable. This jackpot keeps players engaged, as they know that even in rounds where they do not win, they still have a chance to trigger a prize. It adds an unexpected element to the game, making every round more exciting and reducing the frustration associated with losing. Players feel more motivated to stay in the game, knowing that shared losses may lead to a reward.

### Benefits to Casinos:

For casinos, the All Players Lose Event jackpot helps retain players who may otherwise leave after a series of losses. By turning collective losses into a potential jackpot event, casinos may maintain player engagement and keep the game fun, even during unfavorable rounds. This trigger also encourages players to continue participating, knowing that even if they lose, they still have the chance to win something. The All Players Lose Event jackpot fosters a more positive atmosphere on the gaming floor, helping to reduce player churn and increase overall session lengths.

### Example Walk-Through Scenario:

At a live dealer baccarat table, all five players bet on the “player” hand, and the “banker” hand wins the round. The system detects that all players have lost and triggers the All Players Lose Event Mystery Jackpot, awarding a consolation prize to each of the losing players. The event creates a sense of shared camaraderie among the players, who feel rewarded despite their loss. Other tables notice the event, and players are motivated to stay in the game, hoping to trigger a similar jackpot.

### Example System Procedural Flow:

1. Player Outcome Monitoring:
   The system tracks each player's results during the round, recording whether they win or lose based on the game outcome.
2. All Players Lose Condition Check:
   The system checks if all players at the table or terminals lost the same round, ensuring the condition is met for triggering the jackpot.
3. Jackpot Trigger:
   Once the system confirms that all players lost, it triggers the Mystery Jackpot, distributing a prize to the losing participants.
4. Payout and Notification:
   The players are notified of their consolation jackpot win, and the prize is credited to their accounts.

The event is announced across the casino to promote continued engagement.
5. Logging and Reset:
   The system logs the shared loss event, the players involved, and the jackpot payout. The jackpot resets for the next qualifying round of collective losses.

### Noteworthy Aspects and Features:

This trigger turns a shared loss into a rewarding experience, keeping players engaged even when they are not winning. It creates a more positive and enjoyable atmosphere by rewarding players for staying in the game through difficult rounds. The All Players Lose Event jackpot helps reduce frustration and maintains player retention, ensuring that players stay active and invested in the outcome of each round.

### Mystery Jackpot Triggering Criteria #54—Game-Specific Trigger

### Description and Implementation:

The Game-Specific Trigger activates the Mystery Jackpot when a specific event occurs within a particular game. For example, in blackjack, a player getting two aces of the same suit, or in baccarat, a tie with a total of 8 may trigger the jackpot. This trigger is tailored to the unique features of each game, allowing the casino to customize the triggering conditions based on game-specific rules.

The system monitors the gameplay in real-time to identify when the game-specific event has occurred. This trigger may apply to various games like poker, roulette, or baccarat, each with its own set of conditions that activate the jackpot. For implementation, the system uses algorithms that track card combinations, dice rolls, or wheel spins across multiple ETGTs.

### Benefits to Players:

Players appreciate the excitement added by these unique, game-specific events. Knowing that a rare event may trigger a jackpot adds a layer of anticipation and encourages players to stay engaged with the game. It also rewards players for understanding the intricacies of the game, as they become more familiar with the game-specific conditions that lead to a jackpot.

### Benefits to Casinos:

For casinos, this trigger increases engagement by highlighting the potential for a jackpot win based on exciting in-game events. It creates a more interactive and customized experience for players, promoting longer play sessions. Additionally, these unique triggers may be used in marketing to attract players to specific tables or games where the conditions are more to occur.

### Example Walk-Through Scenario:

In a live dealer blackjack game at an ETGT, a player is dealt two aces of spades in a single hand. This rare event immediately triggers the Mystery Jackpot, surprising the player and adding an unexpected reward to their game session. The system recognizes the card combination and instantly activates the jackpot, distributing the prize to the winning player. Other players observing the event are encouraged to continue playing, hoping that they too may experience a jackpot-triggering event.

### Example System Procedural Flow:

1. Game Round Initiation:
   The system tracks all cards dealt or outcomes generated by the ETGT or LDGT.
2. Event Detection:
   The system compares the ongoing game results to predefined game-specific conditions (e.g., a specific card combination or total) and identifies a match.
3. Trigger Activation:
   When the specific game event occurs, the system activates the Mystery Jackpot.
4. Payout:
   The system announces the jackpot win to the player who triggered the event, and the jackpot amount is credited to their account.
5. Event Logging:
   The system logs the game event and the jackpot payout for record-keeping.

### Noteworthy Aspects and Features:

The Game-Specific Trigger is highly customizable and adaptable to the unique elements of each game, allowing for a more personalized experience for players. It creates additional excitement around rare game events and adds an extra layer of unpredictability to the gameplay.

### Mystery Jackpot Triggering Criteria #55—Side Bet Multiplier Activation

### Description and Implementation:

This Mystery Jackpot is triggered when a player places a side bet that activates a random multiplier within the game. For example, in a game of blackjack or baccarat, players have the option to place side bets that may multiply their winnings. When a player hits a winning combination and a multiplier is randomly applied, the system triggers the Mystery Jackpot.

This trigger may require the ETGT or LDGT system to monitor all side bets and apply multipliers based on predetermined odds. The system may be designed to offer various multipliers (e.g., 2×, 5×, 10×), and the jackpot is triggered when the highest multiplier is activated.

### Benefits to Players:

Players enjoy the thrill of the unexpected multiplier, which may significantly enhance their winnings. The potential for a multiplier to trigger a jackpot adds excitement and encourages players to place side bets more frequently. It also enhances the overall gaming experience by offering larger rewards for riskier plays.

### Benefits to Casinos:

For casinos, this trigger increases the volume of side bets, leading to higher revenue. The excitement generated by the random multipliers may lead to longer play sessions and more frequent participation. Additionally, the multiplier system may be customized to increase player retention by adjusting the odds of triggering a jackpot.

### Example Walk-Through Scenario:

In a baccarat game at an ETGT, a player places a side bet on the tie outcome, which carries a higher risk but offers larger rewards. When the tie occurs, a random multiplier of 10× is applied to the player's winnings. This triggers the Mystery Jackpot, and the system announces the win across all terminals. The player receives both their multiplied winnings and the jackpot payout, creating a surge of excitement on the gaming floor.

### Example System Procedural Flow:

1. Side Bet Placement:
   The player places a side bet, and the system records the amount and type of bet.
2. Game Round Execution:
   The system processes the game round and identifies the outcome. If the outcome matches the player's side bet, the system applies a random multiplier to the winnings.
3. Multiplier Check:
   The system checks if the multiplier meets the jackpot-triggering condition (e.g., the highest possible multiplier).
4. Jackpot Activation:
   If the condition is met, the Mystery Jackpot is triggered, and the system awards the player the jackpot in addition to their multiplied winnings.
5. Event Logging:
   The system logs the side bet, multiplier applied, and jackpot payout for auditing and compliance purposes.

### Noteworthy Aspects and Features:

This trigger combines the excitement of multipliers with the potential for a jackpot, creating a high-reward scenario for players. It adds depth to side betting strategies and may be fine-tuned by casinos to enhance player retention and revenue.

### Mystery Jackpot Triggering Criteria #56—Specific Player Action Sequence

### Description and Implementation:

This trigger activates when a player performs a predefined sequence of actions during a game session. For example, in blackjack, a player may trigger the jackpot by hitting, standing, and doubling down in a specific order during a single round. The sequence is unique to the game and may be customized to include various game actions, such as splits, re-buys, or additional side bets.

The system monitors each player's actions in real-time, analyzing whether the specific sequence of actions has been completed. This trigger encourages strategic play, as players who are aware of the sequence may adjust their actions to try to meet the conditions.

### Benefits to Players:

Players are rewarded for taking calculated risks and making strategic decisions. The possibility of triggering a jackpot through specific game actions adds an exciting challenge, encouraging players to experiment with different strategies. This trigger also enhances player engagement, as it rewards active participation in the game.

### Benefits to Casinos:

Casinos benefit from longer and more engaged gameplay as players attempt to achieve the required sequence of actions. This trigger promotes strategic play, which may increase the complexity and depth of player interaction with the game. Additionally, it creates opportunities for casinos to highlight and promote these specific action sequences in marketing campaigns.

### Example Walk-Through Scenario:

In a blackjack session at an ETGT, a player makes a series of strategic decisions: first hitting to draw another card, then standing with a strong hand, and finally doubling down on the next round. The system recognizes this specific sequence of actions as the trigger for the Mystery Jackpot. The player wins the jackpot, and the system displays the event across the casino, drawing the attention of other players and encouraging them to stay engaged.

### Example System Procedural Flow:

1. Action Tracking:
   The system monitors the player's actions during each game round, recording each decision (hit, stand, double down, etc.).
2. Sequence Check:
   The system continuously checks if the player's actions match the predefined sequence required to trigger the jackpot.
3. Jackpot Activation:
   When the sequence is completed, the system activates the Mystery Jackpot and awards the prize to the player.
4. Event Announcement:
   The system displays the jackpot win across the casino and credits the player's account with the jackpot amount.
5. Logging and Compliance:
   The system logs the specific actions taken by the player, the triggering sequence, and the jackpot payout for auditing purposes.

### Noteworthy Aspects and Features:

This trigger rewards strategic play and adds depth to gameplay by encouraging players to think about their actions. It may be tailored to different games and creates a more interactive gaming experience.

### Mystery Jackpot Triggering Criteria #57—Session Time Trigger

### Description and Implementation:

The Session Time Trigger activates the Mystery Jackpot when a player exceeds a specific session duration. For example, if a player has been continuously playing for more than 60 minutes at an ETGT or LDGT, the jackpot is triggered. The system tracks the duration of each player's session and automatically activates the jackpot once the time threshold is reached.

This trigger rewards long-term engagement and encourages players to remain active at the table. It may be customized based on game type or casino preferences, with different session durations required to trigger the jackpot for different games.

### Benefits to Players:

Players are incentivized to stay longer at the gaming table, knowing that extended playtime may result in a jackpot win. This trigger also rewards loyalty and persistence, creating a more immersive experience. Players who prefer longer sessions are more to feel rewarded for their continued engagement.

### Benefits to Casinos:

For casinos, this trigger promotes longer play sessions, which directly correlates with increased revenue. It also helps in retaining players, as they are motivated to continue playing in hopes of triggering the jackpot based on session duration. Additionally, the Session Time Trigger may be used as a promotional tool to attract players to stay at the tables for extended periods.

### Example Walk-Through Scenario:

A player sits down at an ETGT and begins a session of roulette. After playing for over an hour, the system detects that the player's session time has exceeded the 60-minute threshold. The Mystery Jackpot is automatically triggered, and the player wins the jackpot as a reward for their continued play. The system announces the win to all players, encouraging others to extend their sessions as well.

### Example System Procedural Flow:

1. Session Time Tracking:
   The system tracks the length of time each player has been active at their ETGT or LDGT terminal.
2. Threshold Check:
   The system continuously monitors the session duration and checks if the player has exceeded the predefined time limit.
3. Jackpot Activation:
   When the session time threshold is reached, the system triggers the Mystery Jackpot.
4. Payout and Notification:
   The player is notified of the jackpot win, and the prize is credited to their account or paid out via the terminal.
5. Logging:
   The system logs the session duration, player details, and jackpot payout for record-keeping.

### Noteworthy Aspects and Features:

The Session Time Trigger is particularly effective at promoting player retention by rewarding extended gameplay. It encourages players to remain engaged and may be tailored to different games and session lengths to optimize retention strategies.

### Mystery Jackpot Funding Techniques Example Embodiments

### Mystery Jackpot Funding Technique 1—Side Bet Contributions

### Description and Implementation:

The Side Bet Contributions technique involves allocating a portion of the player's side bets directly to the Mystery Jackpot pool. In this method, during regular gameplay at either a live dealer game table (LDGT) or an Electronic Table Game Terminal (ETGT), players may place optional side bets alongside their primary wager. A percentage of these side bets is automatically funneled into a shared Mystery Jackpot pool. This technique is easily integrated into existing game mechanics, as side bets are already a common feature in many table games like blackjack, baccarat, and poker. The contribution amount from the side bet may be a fixed percentage or a tiered percentage based on the value of the side bet.

For example, if a player places a $5 side bet, a predetermined portion, such as $0.50, would be diverted into the jackpot pool. This contribution system may be applied to any number of players seated at the table or playing on ETGTs, allowing for rapid growth of the jackpot.

### Benefits to Players:

The primary benefit for players is the added excitement and incentive of contributing to a growing Mystery Jackpot with every side bet placed. This system allows players to participate in the jackpot without altering their specific game strategy. Additionally, because side bets are typically smaller than main wagers, the financial barrier to participating in the jackpot is low, which encourages broader player involvement. Players may also enjoy the sense of communal contribution as they see the jackpot grow with each side bet placed.

### Benefits to Casinos:

For casinos, this method provides a consistent, low-risk stream of contributions to the Mystery Jackpot fund, driven by player activity. It enhances the appeal of side bets, leading to increased player engagement and extended gameplay. Casinos may also benefit from the added excitement generated by large jackpot amounts, which may attract more players to the game. By encouraging side bets, casinos may increase their overall revenue without disrupting the primary game mechanics or requiring significant changes to existing systems.

### Example Walk-Through Scenario:

Consider a scenario in a high-end Macau casino offering a live dealer blackjack game at a table with six players. Each player has the option to place a side bet along with their main bet. One of the players, Ms. Chen, opts for a $10 side bet, while the other players choose smaller side bets, ranging from $5 to $15. Once the side bets are placed, 5% of the total side bet value from each player is automatically redirected into the Mystery Jackpot pool. For Ms. Chen's $10 bet, $0.50 is contributed to the pool, while another player's $15 side bet results in a $0.75 contribution.

During the game, Ms. Chen continues to place both main bets and side bets over several hands. With each hand, the jackpot pool grows incrementally. After about an hour of gameplay, the casino's jackpot pool reaches a significant sum, attracting even more attention from passersby. As the jackpot nears a certain threshold, the casino announces the growing prize pool via a large display near the gaming table and sends alerts to ETGTs linked to the same jackpot system across the casino floor. This further incentivizes more players to participate by placing side bets, creating a feedback loop of engagement and contributions to the jackpot.

### Example System Procedural Flow:

1. Player Interaction with LDGT/ETGT:
   A player approaches the live dealer table or ETGT, where they have the option to place a side bet alongside the main wager.
   The player places their side bet, which is registered by the dealer's terminal or ETGT interface.
2. ETGT/LDGT Processing the Bet:
   The system detects the side bet and calculates the appropriate contribution to the Mystery Jackpot pool based on pre-configured rules (e.g., 5% of the side bet).
   The dealer's terminal or ETGT sends this bet data to the casino's gaming server, along with the main game wager information.
3. Casino Network Interaction:
   The gaming server processes the side bet contribution data from multiple terminals or LDGTs across the casino.
   The contribution amounts from all players are added to the existing Mystery Jackpot pool, with the updated total displayed across various screens and terminals in the casino.
4. Jackpot Pool Update and Display:
   The casino network pushes real-time updates of the Mystery Jackpot pool to all participating tables and ETGTs. Players and dealers are notified of the new jackpot total.
   If a predetermined jackpot threshold is met, alerts are triggered across the network, notifying players that the jackpot is close to being awarded.
5. Player Jackpot Eligibility:
   Throughout gameplay, the system tracks which players have made side bet contributions. If a Mystery Jackpot trigger event occurs, such as a specific card combination, the system checks player eligibility based on their contribution history.
   The system awards the jackpot to the eligible player and deducts the winning amount from the pool.
6. Jackpot Reset:
   After the jackpot is won, the system resets the jackpot pool and continues to accumulate new contributions from ongoing side bets.

### Noteworthy Aspects and Features:

This Mystery Jackpot funding technique is novel in that it integrates seamlessly with existing side betting mechanics, offering a dual-layered engagement for players-both in the specific game and in the jackpot event. The technique benefits from dynamic, real-time data sharing across the casino network, enabling all players across multiple terminals to contribute to and track the progress of the jackpot. The system's ability to handle contributions from both LDGTs and ETGTs, as well as across multiple games, differentiates it from earlier progressive jackpot methods, which were typically game-specific and did not involve side bets as a funding source. This widespread connectivity and contribution model make it particularly attractive in casino markets like Macau, where player engagement is notable to driving game participation.

### Mystery Jackpot Funding Technique #2—Tiered Bet Contributions

### Description and Implementation:

The Tiered Bet Contributions method involves scaling contributions to the Mystery Jackpot pool based on the tier or value of the player's wager. Higher wagers contribute a larger percentage of the bet to the jackpot pool compared to lower wagers. For example, players who place bets of $10 or more may contribute 5% of their wager, while those betting under $10 contribute 2%. This system encourages higher wagers by offering a proportional contribution mechanism, which may attract high-stakes players while still allowing casual players to contribute. The tiered system may be implemented at both Live Dealer Game Tables (LDGTs) and Electronic Table Game Terminals (ETGTs), where the game system automatically calculates the percentage of each bet to be funneled into the jackpot pool based on preset tier structures.

### Benefits to Players:

Players benefit from Tiered Bet Contributions by receiving a sense of fairness: the more they bet, the more they contribute, and potentially the more significant their portion of the jackpot winnings may be. This technique also appeals to a wide range of players by allowing everyone to participate in the jackpot, regardless of their betting tier. High rollers feel rewarded for larger bets, while casual players may still engage with smaller contributions. Additionally, the sense of scaling contributions builds excitement, as higher bets directly fuel the rapid growth of the jackpot pool.

### Benefits to Casinos:

Casinos benefit from this funding technique by incentivizing larger wagers, which may boost overall revenue. Since contributions to the Mystery Jackpot increase with higher bets, casinos may accumulate a substantial jackpot pool more quickly, which attracts more players. The tiered structure offers flexibility in adjusting the contribution percentages to balance between casual and high-stakes players, ensuring steady jackpot growth while maintaining player engagement across different bet levels. This system also encourages long-term player retention, as players aim to increase their bets to maximize their participation in the growing jackpot.

### Example Walk-Through Scenario:

At a high-end baccarat table in a bustling Macau casino, multiple players are seated at a live dealer table. Players like Mr. Zhang and Ms. Wei place their bets, with Mr. Zhang betting $50 per hand, and Ms. Wei opting for a smaller $5 bet. Under the Tiered Bet Contributions system, Mr. Zhang's wager qualifies for the higher contribution tier, meaning that 5% of his $50 bet ($2.50) is automatically allocated to the Mystery Jackpot pool. On the other hand, Ms. Wei's $5 bet qualifies for the lower tier, contributing 2%, or $0.10, to the jackpot.

As the game progresses, each new wager from the players contributes to the growing jackpot pool based on their respective tiers. Both Mr. Zhang and Ms. Wei are eligible to win the Mystery Jackpot, but the larger portion contributed by Mr. Zhang gives him a slight edge in triggering a larger payout percentage should the jackpot be won.

By the end of the gaming session, the tiered contribution structure has driven rapid growth in the jackpot pool, creating a buzz among players at the table. The casino's central display system highlights the jackpot's significant value, attracting additional players who are eager to place larger wagers to contribute more substantially to the jackpot.

### Example System Procedural Flow:

1. Player Interaction:
   Players approach the live dealer or ETGTs and place their wagers, with the system automatically detecting the amount of each bet.
2. Contribution Calculation:
   The LDGT/ETGT system applies the predefined tier structure. For each bet placed, the contribution percentage (e.g., 5% for bets over $10, 2% for bets under $10) is calculated.
3. Data Transmission to Casino Server:
   The betting data, including the wager amount and corresponding jackpot contribution, is transmitted from the LDGT/ETGT to the central casino gaming server.
4. Jackpot Pool Update:
   The server aggregates the contributions from all tables and terminals. The Mystery Jackpot pool is updated in real-time, and the new total is displayed on jackpot monitors throughout the casino.
5. Eligibility Check:
   When a jackpot event is triggered, the system checks the player's contribution tier to determine eligibility and the portion of the jackpot payout, ensuring that higher tier contributors may receive a proportional payout based on their contributions.
6. Payout Distribution:
   If a player wins the Mystery Jackpot, the system computes the payout according to the player's contribution tier. The system then awards the appropriate share of the jackpot to the player.

### Noteworthy Aspects and Features:

This tiered approach introduces a novel concept by offering varied contribution percentages based on bet size, directly influencing the speed at which the jackpot pool grows. The flexibility of this system allows casinos to target different player segments, encouraging larger bets from high-stakes players while still welcoming smaller contributions from casual players. The real-time calculation and pooling of jackpot funds from various bet levels create an engaging experience for players, while the proportional payout structure ensures fairness. The tiered system's adaptability to different games and wager types makes it an innovative approach that stands apart from simpler flat-rate jackpot contribution models.

### Mystery Jackpot Funding Technique #3—Fixed Ante Contribution

### Description and Implementation:

The Fixed Ante Contribution method involves taking a small, predefined amount from each player's initial wager (the ante) and contributing it directly to the Mystery Jackpot pool. This method is straightforward and works well for games where an ante is a required part of the betting process, such as poker or some blackjack variations. Each time a player joins the game and places an ante, a fixed portion of that ante, such as $0.50 or $1, is diverted to the jackpot pool. This system is easy to implement across both Live Dealer Game Tables (LDGTs) and Electronic Table Game Terminals (ETGTs), where the ante may be automatically split between the main game pool and the jackpot pool.

### Benefits to Players:

The fixed ante contribution provides players with the assurance that their participation in the game also enters them into the running for the Mystery Jackpot. Since the contribution is fixed, players may easily understand how much of their ante is allocated toward the jackpot. This creates a consistent and transparent system that allows all players an equal chance to participate in the jackpot, regardless of their wager amount. It adds an extra layer of excitement, knowing that each hand contributes toward a growing jackpot, offering the potential for a life-changing payout.

### Benefits to Casinos:

For casinos, the fixed ante contribution offers a predictable and stable method of funding the Mystery Jackpot. The fixed nature of the contribution ensures that every player at the table is contributing the same amount, making it easier to manage the growth of the jackpot. This method also promotes steady jackpot accumulation, which may lead to larger jackpot amounts over time, driving player interest and increasing table traffic. Additionally, because this method is simple and easy to explain to players, it reduces the need for complicated promotional efforts or explanations from casino staff.

### Example Walk-Through Scenario:

Imagine a busy poker table in a popular casino in Macau. Players are required to place a $5 ante to participate in each hand. Under the Fixed Ante Contribution system, the casino has set a fixed amount of $0.50 to be automatically allocated to the Mystery Jackpot pool from each player's ante. This process is seamless; when a player places their ante, the casino system splits the contribution, directing $4.50 toward the game's main pot and $0.50 toward the jackpot pool.

As each new hand is dealt, the jackpot pool grows consistently with each player's ante. After several rounds, the jackpot pool reaches a significant sum, displayed prominently on a monitor above the table. Players are excited to see the pool grow as they continue playing, knowing that at any moment, one lucky hand may trigger the jackpot.

In this session, Mr. Li, a regular player, wins a notable hand and is subsequently entered into the drawing for the Mystery Jackpot. His win qualifies him to trigger the jackpot, which has grown substantially due to the steady contributions from each player's ante throughout the session. The casino's system checks Mr. Li's eligibility and awards him the jackpot, much to the delight of the table.

### Example System Procedural Flow:

1. Player Ante Placement:
   The player sits down at the LDGT or ETGT and places their initial ante, as required by the game.
2. Contribution Allocation:
   The system automatically deducts a fixed portion (e.g., $0.50) from the ante and allocates it to the Mystery Jackpot pool, while the rest is directed to the game pot.
3. Casino Network Interaction:
   The LDGT/ETGT transmits ante data, including the fixed contribution, to the casino server, which updates the jackpot pool total in real-time.
4. Jackpot Pool Display:
   The updated jackpot total is displayed on casino monitors, allowing players to see the growing pool as more hands are played and more antes are contributed.
5. Player Qualification:
   During gameplay, if a qualifying hand or event occurs (e.g., a royal flush or a special winning hand), the system checks the player's contribution history to verify jackpot eligibility.
6. Jackpot Payout:
   If the player qualifies, the system calculates the jackpot payout and awards it, notifying all participants at the table.

### Noteworthy Aspects and Features:

The Fixed Ante Contribution system is notable for its simplicity and predictability. It ensures that all players, regardless of their betting patterns, contribute equally to the jackpot pool, creating a sense of fairness. The real-time integration of jackpot contributions and displays enhances player engagement, as the steadily growing pool is visible to all. This system's efficiency and transparency make it an attractive option for casinos, especially in high-traffic gaming environments like those found in Macau, where streamlined operations are notable.

### Mystery Jackpot Funding Technique #4—Percentage of Dealer Wins

### Description and Implementation:

The Percentage of Dealer Wins technique involves contributing a portion of the dealer's winnings into the Mystery Jackpot pool. In this system, every time the dealer wins a hand, a fixed percentage of the total winnings is automatically transferred into the jackpot pool. This method capitalizes on dealer dominance in certain games like blackjack or baccarat, ensuring that the house's edge contributes to jackpot growth. It may be implemented seamlessly at both Live Dealer Game Tables (LDGTs) and Electronic Table Game Terminals (ETGTs), where the system automatically calculates and deducts the percentage after each dealer win.

### Benefits to Players:

Players benefit from this method because it ensures consistent growth of the Mystery Jackpot without requiring additional contributions from their own wagers. Knowing that every time the dealer wins, the jackpot grows, players may enjoy the satisfaction of contributing to the jackpot even in losing hands. This system also introduces an interesting dynamic: while players compete to beat the dealer, they simultaneously root for the dealer to win certain hands in order to increase the jackpot pool.

### Benefits to Casinos:

For casinos, this technique creates a unique and engaging incentive for players, encouraging longer gameplay even during sessions where the dealer is on a winning streak. It also capitalizes on the casino's house edge, effectively using dealer wins as a method of growing the jackpot pool. This system does not may require any additional player wagers or contributions, meaning that it generates additional excitement without affecting the player's specific gaming experience. Additionally, the constant growth of the jackpot may attract more players, especially in high-stakes environments.

### Example Walk-Through Scenario:

In a Macau casino, a blackjack table is bustling with activity. Several players, including Mr. Wong and Ms. Liu, are competing against the dealer, who has been on a winning streak for several hands. Under the Percentage of Dealer Wins system, every time the dealer wins a hand, 3% of the total amount won by the dealer is automatically allocated to the Mystery Jackpot pool. In one particular hand, the dealer wins $500 from the collective bets of the players. As soon as the dealer's win is confirmed, the system transfers $15 (3%) into the growing jackpot pool.

The players, despite losing this round, take solace in the fact that their losses have at least contributed to the jackpot. As the session continues and the dealer racks up more wins, the jackpot pool grows steadily. By the end of the night, the jackpot reaches a significant amount, increasing the anticipation and excitement at the table. Players continue to engage with the game, knowing that every dealer win contributes to a larger, more enticing prize.

### Example System Procedural Flow:

1. Player Bets and Dealer Win:
   Players place their bets, and the game proceeds. The dealer wins a hand, collecting the total wagered amount.
2. Percentage Deduction:
   The system calculates a fixed percentage (e.g., 3%) of the dealer's winnings and designates it for the Mystery Jackpot pool.
3. Casino Network Data Transfer:
   The LDGT/ETGT sends the dealer's win data and the jackpot contribution amount to the casino server, which updates the jackpot total.
4. Jackpot Display Update:
   The updated jackpot pool is displayed on screens throughout the casino, informing players of the current jackpot value.
5. Jackpot Growth:
   As more hands are played and the dealer continues to win, the jackpot pool accumulates steadily, contributing to the overall excitement at the table.
6. Jackpot Payout and Reset:
   When the jackpot is triggered by a winning player or event, the system verifies eligibility and awards the jackpot accordingly, resetting the pool for the next round.

### Noteworthy Aspects and Features:

The Percentage of Dealer Wins technique introduces a novel way to fund the jackpot, leveraging dealer success to fuel jackpot growth. This method ensures that the house's advantage directly benefits the jackpot pool, which contrasts with traditional player-driven funding techniques. It offers an engaging twist for players, as they indirectly benefit from dealer wins even when they lose individual hands. The real-time tracking and contribution mechanism ensures continuous jackpot accumulation, enhancing player engagement without additional effort or cost. This technique is particularly suited to games with a strong dealer presence, making it a compelling option for casinos looking to offer a fresh, interactive jackpot system.

### Mystery Jackpot Funding Technique #5—Random Bet Selection Contribution

### Description and Implementation:

The Random Bet Selection Contribution method involves randomly selecting certain player bets during gameplay and directing a portion of these bets to the Mystery Jackpot pool. This system introduces an element of unpredictability and excitement for players, as they do not know which of their bets will be chosen for contribution. The selection of the bets to contribute may be triggered by a random number generator (RNG) integrated into the Live Dealer Game Table (LDGT) system or the Electronic Table Game Terminal (ETGT). Each time a bet is selected, a pre-determined percentage of that bet (e.g., 5%) is funneled into the jackpot pool. This system is ideal for games that rely heavily on luck, such as roulette, blackjack, or baccarat, as it adds an additional layer of suspense and engagement for the players.

### Benefits to Players:

Players enjoy the excitement of knowing that any bet they place may contribute to the Mystery Jackpot pool. This system also levels the playing field, as all players, regardless of their betting amount, have an equal chance of having their bets selected for contribution. The random nature of the contributions ensures that everyone is part of the action, and it allows players to feel like their participation is constantly contributing to the overall experience. The element of randomness enhances engagement, as players are motivated to continue betting in the hopes that their bet will be chosen.

### Benefits to Casinos:

For casinos, this method increases player engagement and overall betting volume. The randomness ensures that the jackpot pool grows at unpredictable intervals, which adds to the suspense and excitement for players. Additionally, since contributions are taken randomly from player bets, casinos may continuously grow the jackpot without needing to adjust the gameplay or may require specific betting actions from players. The implementation of RNG systems in modem casinos is already widespread, making it easy to integrate this method into existing gaming infrastructure.

### Example Walk-Through Scenario:

Consider a busy blackjack table at a Macau casino. Players like Mr. Tan and Ms. Lee are placing their bets for each hand, unaware of which bets will contribute to the Mystery Jackpot. During one round, Mr. Tan places a $20 bet, while Ms. Lee places a $10 bet. Unbeknownst to the players, the casino's system randomly selects Mr. Tan's bet to contribute 5% to the jackpot pool, meaning $1 is automatically allocated to the Mystery Jackpot.

As the game progresses, the system continues to randomly select bets from various players, contributing portions of their wagers to the pool. Mr. Tan, excited by the possibility of contributing more, increases his bet in the next round. Ms. Lee, noticing the growing jackpot displayed on the monitor, follows suit. Over the course of the session, numerous bets are selected at random, resulting in a steadily growing jackpot pool that fuels the anticipation of all players at the table.

### Example System Procedural Flow:

1. Player Bet Placement:
   Players place their bets at the LDGT or ETGT. These bets are tracked by the system as usual.
2. Random Selection Trigger:
   The system uses an RNG to select certain bets for contribution. The selection occurs after the bets are placed but before the hand or game begins.
3. Contribution Allocation:
   For the selected bets, a predetermined percentage (e.g., 5%) is deducted from the total and added to the Mystery Jackpot pool.
4. Casino Network Data Transfer:
   The contribution amounts are transmitted to the casino server, where the total jackpot pool is updated and displayed on monitors.
5. Player Notification:
   Players are informed in real-time if their bet has been selected for contribution, which encourages excitement and engagement as they see the jackpot grow.
6. Jackpot Pool Update:
   The jackpot continues to accumulate with each random contribution, and the casino network system tracks all contributions for future payout calculations.

### Noteworthy Aspects and Features:

The Random Bet Selection Contribution technique stands out for its unpredictability and the excitement it generates. Players are constantly engaged, knowing that any bet may contribute to the jackpot, which encourages continuous betting and long play sessions. This system is easy for casinos to implement using existing RNG technology, and it may require no extra effort or decision-making from players. The randomness ensures that contributions come from a wide variety of bet sizes, making the jackpot growth fair and evenly distributed across players. The suspense it generates is particularly appealing in fast-paced gaming environments like Macau, where players enjoy dynamic and interactive gameplay.

### Mystery Jackpot Funding Technique #6—Progressive Bet Matching

### Description and Implementation:

In the Progressive Bet Matching method, the casino matches a percentage of certain high-value player bets as contributions to the Mystery Jackpot pool. This technique rewards players who place larger wagers by having the house contribute a portion of the wager into the jackpot pool, essentially doubling the impact of those higher bets. For example, if a player places a $50 bet, the casino may match 10% of that amount ($5) and add it to the Mystery Jackpot pool. This system is particularly suited to attract high-stakes players who seek more significant rewards for their larger wagers.

This funding technique is typically implemented at games where bet sizes vary greatly, such as baccarat or blackjack, and is especially useful in ETGTs where bet amounts are easily tracked and analyzed by the casino system. By automatically matching a percentage of large bets, the casino may foster a faster-growing jackpot pool and create an incentive for players to place higher wagers.

### Benefits to Players:

Players benefit from Progressive Bet Matching by seeing their contributions to the Mystery Jackpot amplified by the casino. High-stakes players are especially motivated to place larger bets, knowing that the casino will contribute additional funds to the jackpot on their behalf. This method offers a feeling of added value, as players realize that their betting activity not only increases their potential winnings in the primary game but also boosts the overall jackpot, making it more that the next big payout will be substantial.

### Benefits to Casinos:

Casinos benefit from this technique by encouraging players to place larger wagers, which directly increases both the house's revenue and the jackpot pool's growth. The ability to match a portion of large bets helps the casino maintain a strong house edge while still providing an attractive incentive for high-stakes players. Additionally, this system creates a dynamic gameplay environment where players are aware of how much they are contributing to the jackpot and how the casino is rewarding their gameplay. The increased engagement from higher betting volumes may result in longer play sessions and more consistent revenue streams.

### Example Walk-Through Scenario:

At an exclusive baccarat table in a Macau casino, Ms. Li, a high-stakes player, places a $100 bet. The casino's Progressive Bet Matching system automatically kicks in, matching 10% of her bet and contributing $10 to the Mystery Jackpot pool. Other players at the table, who have placed smaller bets, notice the rapid increase in the jackpot displayed on the monitor, which encourages them to increase their own wagers.

During the next round, Mr. Wang, intrigued by the growing jackpot, decides to place a $200 bet. The casino matches 10% of his bet, contributing $20 to the pool. As the session continues, the casino matches a portion of each high-value bet, leading to a significantly larger jackpot by the end of the night. Players remain engaged, knowing that their higher wagers are not only increasing their potential winnings in the game but also rapidly inflating the jackpot pool.

### Example System Procedural Flow:

1. Player Bet Placement:
   Players place their wagers at the LDGT or ETGT. The system tracks the bet amount and determines whether it qualifies for Progressive Bet Matching.
2. Casino Match Calculation:
   The system calculates the matching contribution from the casino, typically a percentage (e.g., 10%) of the qualifying bet.
3. Contribution Allocation:
   The matched amount is added to the Mystery Jackpot pool and updated in real-time.
4. Casino Network Data Transmission:
   The casino server receives data on both player bets and casino contributions, updating the jackpot pool total accordingly.
5. Jackpot Pool Growth:
   The jackpot grows progressively as more high-value bets are matched by the casino. Players may view the increasing jackpot on monitors, which encourages higher wagers.
6. Jackpot Distribution:
   When the jackpot is triggered, the system verifies the contribution amounts and distributes the winnings accordingly.

### Noteworthy Aspects and Features:

The Progressive Bet Matching system is novel in that it encourages high-stakes play by directly rewarding larger wagers with a casino-matched contribution to the jackpot. This method not only boosts player engagement but also enhances the house's ability to grow the jackpot pool at a faster rate. It provides clear incentives for players to increase their bets, knowing that the casino will contribute more to the pool as their bets increase. The matching mechanism, integrated into the ETGT or LDGT systems, ensures seamless operation and real-time updates to the jackpot total, adding excitement and transparency to the gameplay.

### Mystery Jackpot Funding Technique #7—Loyalty Points Conversion

### Description and Implementation:

The Loyalty Points Conversion method allows players to convert their accumulated loyalty points into contributions for the Mystery Jackpot pool. Casinos often reward players with loyalty points based on their gameplay, which may typically be redeemed for perks like meals, hotel stays, or free play. With this method, players are given the option to voluntarily convert a portion of their loyalty points into a direct contribution to the jackpot. For instance, 100 loyalty points may be equivalent to a $1 contribution to the Mystery Jackpot pool.

This funding technique may be implemented through a player's casino account, accessible via ETGTs or player tracking systems. When a player logs into their account at an ETGT, they may choose to convert points to increase their chances of triggering the Mystery Jackpot. This method not only adds to the pool but also enhances player engagement by linking the casino's loyalty program directly to jackpot opportunities.

### Benefits to Players:

Players benefit from this system by gaining more control over their loyalty points and how they are used. The ability to convert points into jackpot contributions gives players an additional, exciting option for utilizing their rewards. It also creates an incentive for frequent players to stay loyal to the casino, as they may see their loyalty points directly contribute to the possibility of winning a large jackpot. This method also helps players feel more involved in the jackpot's growth, as their accumulated rewards play a part in inflating the prize pool.

### Benefits to Casinos:

Casinos benefit from the Loyalty Points Conversion method by creating a deeper integration between their loyalty programs and gameplay. Offering players more flexibility in how they use their loyalty points encourages continued engagement with the casino, increasing both playtime and overall spending. This method also provides casinos with a way to “reclaim” loyalty points, converting them into funds that fuel the jackpot, thus enhancing player satisfaction without directly impacting casino profits.

### Example Walk-Through Scenario:

Ms. Chao is a frequent player at a Macau casino and has accumulated 10,000 loyalty points over several months of gameplay. When she sits down at an ETGT, she is presented with the option to convert some of her points into contributions to the Mystery Jackpot pool. Interested in the opportunity to win big, she converts 1,000 points, which translates into a $10 contribution to the jackpot pool.

Throughout the session, other players also take advantage of the Loyalty Points Conversion system, contributing varying amounts based on their loyalty point balance. As the pool grows, players are motivated to continue converting points, knowing that their loyalty directly impacts the size of the potential jackpot. By the end of the session, the jackpot has grown substantially, and Ms. Chao feels more invested in the game, knowing that her points played a notable role in building the prize.

### Example System Procedural Flow:

1. Player Loyalty Point Accumulation:
   As players engage with the casino, they earn loyalty points through various activities, tracked in their player account.
2. Conversion Option:
   When players log into an ETGT or LDGT, they are offered the option to convert a portion of their loyalty points into a contribution to the Mystery Jackpot.
3. Points Conversion:
   The system calculates the conversion rate (e.g., 100 points=$1) and transfers the equivalent amount to the jackpot pool.
4. Casino Network Update:
   The casino server receives the updated contribution data and increases the jackpot pool accordingly, displaying the new total on screens throughout the casino.
5. Player Tracking and Notification:
   Players receive notifications confirming their point conversion and contribution to the jackpot pool, which encourages further participation.
6. Jackpot Trigger and Payout:
   Once the jackpot is triggered, the system verifies all contributions, including those from loyalty point conversions, and distributes the prize accordingly.

### Noteworthy Aspects and Features:

The Loyalty Points Conversion technique introduces a unique way for players to use their accumulated rewards, offering them more flexibility and engagement. The ability to convert points into direct contributions to the jackpot strengthens the relationship between loyalty programs and gameplay, enhancing player retention and satisfaction. For casinos, this method allows for the efficient utilization of loyalty points while creating excitement around the jackpot. The seamless integration of loyalty systems with the jackpot pool ensures that players feel involved in the growing prize, making this technique particularly appealing in highly competitive markets like Macau.

### Mystery Jackpot Funding Technique #8—Multiplayer Win Rollover

### Description and Implementation:

The Multiplayer Win Rollover method directs a portion of winnings from simultaneous or multiple-player wins into the Mystery Jackpot pool. In games where multiple players may win in the same round, such as baccarat or blackjack, this method ensures that a percentage of each player's winnings is contributed to the jackpot pool. For example, if three players win a hand of blackjack at the same time, 2% of each player's winnings may be allocated to the Mystery Jackpot.

This technique creates a cooperative aspect within competitive gameplay, as players see their collective success directly contributing to the jackpot pool. It may be implemented easily across both Live Dealer Game Tables (LDGTs) and Electronic Table Game Terminals (ETGTs), where the system automatically deducts the percentage from winnings and directs it to the jackpot.

### Benefits to Players:

Players benefit from Multiplayer Win Rollover because it adds excitement to cooperative victories. Even in competitive games, players are incentivized to root for each other, knowing that multiple wins in the same round will grow the jackpot. This method also enhances the sense of community and camaraderie at the table, as simultaneous wins lead to a collective contribution to a larger potential prize. The cooperative nature of this system keeps players engaged and excited, even when they are not directly winning the jackpot themselves.

### Benefits to Casinos:

Casinos benefit by encouraging higher player participation and engagement. The prospect of contributing to a growing jackpot through multiplayer wins fosters a sense of excitement, drawing players to games where multiple winners are possible. This method also creates opportunities for faster jackpot growth, as simultaneous wins may lead to multiple contributions in a single round. By encouraging a cooperative dynamic among players, casinos may increase table occupancy and session length, boosting overall revenue.

### Example Walk-Through Scenario:

At a busy blackjack table in a Macau casino, four players-Ms. Zhao, Mr. Li, Mr. Chen, and Ms. Fang—are competing against the dealer. In one round, all four players win their hands, with varying payouts based on their wagers. Under the Multiplayer Win Rollover system, 2% of each player's winnings is automatically directed to the Mystery Jackpot pool.

Ms. Zhao, who won $100, contributes $2, while Mr. Chen, who won $300, contributes $6. The total contribution from the group adds up to $12 for that round, significantly boosting the jackpot pool in one round of play. As the session continues, other rounds of simultaneous player wins lead to additional contributions, rapidly growing the jackpot. The players, while competing against the dealer, enjoy the collective achievement of seeing their contributions build a potential life-changing prize.

### Example System Procedural Flow:

1. Player Bet Placement:
   Players place their bets for the round at the LDGT or ETGT. The system tracks each player's bet amount.
2. Simultaneous Win Detection:
   The system monitors the outcome of the round and detects if multiple players have won simultaneously.
3. Contribution Deduction:
   A predefined percentage (e.g., 2%) of each player's winnings is deducted and allocated to the Mystery Jackpot pool.
4. Casino Network Update:
   The LDGT/ETGT system sends the deduction data to the casino server, which updates the jackpot pool and displays the new total to players.
5. Real-Time Player Notification:
   Players are informed that their win has contributed to the jackpot, which boosts engagement and excitement.
6. Jackpot Pool Growth:
   As more simultaneous wins occur throughout the session, the jackpot pool continues to grow, creating anticipation among the players.

### Noteworthy Aspects and Features:

The Multiplayer Win Rollover technique introduces a cooperative element into competitive games, fostering a sense of community among players. The ability for multiple players to contribute to the jackpot through simultaneous wins accelerates the pool's growth, making it particularly appealing in fast-paced environments. This method encourages players to continue participating in group games, knowing that their success directly benefits the jackpot. The dynamic of shared victory aligns with the social atmosphere often found in Macau's casinos, where players enjoy the thrill of contributing to a collective goal.

### Mystery Jackpot Funding Technique #9—Casino-Wide Bet Aggregation

### Description and Implementation:

The Casino-Wide Bet Aggregation technique involves pooling a small percentage of all bets placed across multiple games and Electronic Table Game Terminals (ETGTs) within a casino, directing these contributions to a single, large Mystery Jackpot pool. This method allows for the rapid growth of the jackpot since it draws contributions from a wide range of games, including popular table games like blackjack, baccarat, roulette, and poker, as well as from slot machines and ETGTs. The system may be configured to automatically collect a fixed percentage (e.g., 1%) from each bet placed, regardless of the game type, and aggregate these contributions into a central jackpot pool accessible to all eligible players.

This technique is particularly suited for large, high-traffic casinos, where numerous games are played simultaneously, ensuring consistent and significant contributions to the jackpot pool. With casino-wide aggregation, players across various games all have a stake in the potential jackpot, enhancing cross-game engagement and participation.

### Benefits to Players:

For players, Casino-Wide Bet Aggregation offers the appeal of a rapidly growing jackpot pool fueled by bets placed across an entire casino. The system allows players to contribute to and compete for a large jackpot, even if they are playing different games. This method enhances the overall excitement of the casino experience, as players feel connected to the jackpot regardless of which game they choose to play. The prospect of winning a large, multi-game jackpot adds an extra layer of excitement to every bet, encouraging players to stay engaged longer and try different games, knowing that all their wagers contribute to the same jackpot.

### Benefits to Casinos:

Casinos benefit from this method by leveraging the entire spectrum of their games to build a single, highly attractive Mystery Jackpot. Since the contributions are spread across a wide range of games, the jackpot grows quickly, creating significant player interest. This method also encourages players to explore and participate in different games throughout the casino, driving more traffic to various gaming areas and machines. The visibility of the large jackpot, prominently displayed across the casino floor, helps attract new players and retain existing ones, while the incremental contributions from each bet ensure steady, low-cost funding for the jackpot.

### Example Walk-Through Scenario:

At a bustling Macau casino, thousands of bets are being placed simultaneously across various gaming tables and ETGTs. Players at the blackjack tables, roulette wheels, and even on slot machines are all contributing to a central Mystery Jackpot pool through a Casino-Wide Bet Aggregation system. Each time a player places a bet, whether it's $5 at the baccarat table or $100 at a poker game, a small percentage (e.g., 1%) of that bet is automatically funneled into the growing jackpot.

Ms. Lin, who is playing blackjack, watches as the jackpot displayed on a large screen near her table increases every minute, thanks to contributions from players across the casino. Meanwhile, Mr. Zhang, playing on an ETGT slot machine, also sees the jackpot amount rise as his slot bet contributes to the same pool. Both players are aware that their participation in any game is contributing to the massive prize, which may be triggered at any moment by any eligible player in the casino.

### Example System Procedural Flow:

1. Player Bet Placement:
   Players at various LDGTs, ETGTs, and slot machines place their bets, and the system tracks each bet in real time.
2. Aggregation of Contributions:
   A predefined percentage (e.g., 1%) of each bet placed is automatically deducted and directed into the central Mystery Jackpot pool.
3. Data Transmission to Casino Server:
   The contribution data from all gaming terminals and tables is sent to the central casino server, where the total jackpot pool is updated.
4. Real-Time Jackpot Update:
   The updated jackpot total is displayed on large monitors and screens throughout the casino, allowing all players to see the current prize pool.
5. Eligibility and Jackpot Trigger:
   The system continuously monitors for qualifying jackpot events across all participating games. If a player triggers the jackpot, the system verifies the player's contribution history and eligibility.
6. Jackpot Payout and Reset:
   Once the jackpot is won, the system distributes the prize and resets the jackpot pool for continued aggregation.

### Noteworthy Aspects and Features:

Casino-Wide Bet Aggregation is a novel and powerful technique that unifies contributions from a wide variety of games, making the Mystery Jackpot grow faster than traditional game-specific jackpots. It fosters a sense of interconnectedness across the entire casino, as players from different games collectively contribute to the same jackpot. The system's scalability and integration across multiple platforms (LDGTs, ETGTs, and slot machines) ensure that all players have an equal opportunity to win, regardless of the game they choose to play. This feature enhances the casino's overall atmosphere, drawing in more players and keeping them engaged.

### Mystery Jackpot Funding Technique #10—Wager Rounding

### Description and Implementation:

The Wager Rounding technique involves rounding up each player's bet to the nearest dollar and contributing the rounded-up difference to the Mystery Jackpot pool. For instance, if a player places a bet of $9.75, the system automatically rounds it up to $10, with the extra $0.25 going into the jackpot fund. This method is especially appealing because it allows for small, seamless contributions that are virtually unnoticeable to the player while still providing a steady stream of funding for the jackpot.

This technique may be implemented across both Live Dealer Game Tables (LDGTs) and Electronic Table Game Terminals (ETGTs), where the system automatically calculates and allocates the rounded-up portion of each wager. The simplicity and transparency of this system make it an effective way to generate consistent contributions to the jackpot without requiring players to make additional decisions or place separate bets.

### Benefits to Players:

Players appreciate the simplicity of Wager Rounding because it may require no additional action on their part. The system rounds up their bets automatically, and the small contributions to the jackpot are practically imperceptible. Despite the minimal individual contribution, players still gain the satisfaction of knowing they are contributing to a growing jackpot, which may lead to a significant payout. This method also appeals to players who prefer low-risk contributions to jackpots, as the incremental amounts from rounding are modest and easy to overlook.

### Benefits to Casinos:

Casinos benefit from this technique by generating a steady stream of small, incremental contributions to the jackpot without requiring significant changes to the betting process. Since the rounded amounts are minimal, players are unlikely to object, and the jackpot pool grows continuously throughout the day. The Wager Rounding method also enhances the overall player experience by integrating a seamless and automatic way to participate in the jackpot, potentially extending play sessions and increasing bet volumes.

### Example Walk-Through Scenario:

At a baccarat table in a high-traffic Macau casino, players are placing a variety of bets. Mr. Wong places a $15.50 bet, which the system rounds up to $16. The extra $0.50 is automatically contributed to the Mystery Jackpot pool. At the same table, Ms. Zhang places a $22.75 bet, and the system rounds it up to $23, contributing the $0.25 difference to the jackpot.

As the session progresses, every wager is rounded up to the nearest dollar, with the excess amounts being funneled into the jackpot pool. Players barely notice the small contributions, but the overall impact on the jackpot is substantial, as these incremental amounts add up over time. By the end of the session, the jackpot pool has grown significantly, thanks to the consistent rounding contributions from each bet placed.

### Example System Procedural Flow:

1. Player Bet Placement:
   Players place their bets at the LDGT or ETGT. The system records each bet amount and calculates the difference between the bet and the nearest dollar.
2. Rounding Calculation:
   The system rounds the wager up to the nearest dollar and identifies the extra amount (e.g., $0.25).
3. Contribution to Jackpot Pool:
   The rounded-up difference is allocated to the Mystery Jackpot pool, while the original wager is applied to the game.
4. Casino Server Data Transmission:
   The contribution data is sent to the casino's central server, where the total jackpot pool is updated in real time.
5. Jackpot Display:
   The updated jackpot total is displayed on monitors throughout the casino, creating a visible incentive for players.
6. Eligibility and Jackpot Payout:
   When the jackpot is triggered, the system verifies the player's contributions and awards the prize accordingly.

### Noteworthy Aspects and Features:

The Wager Rounding technique is a simple yet highly effective way to generate consistent jackpot contributions. Its low-impact nature ensures that players may contribute without feeling any financial burden, while the automatic rounding system keeps the process seamless and efficient. The method's transparency and ease of use make it particularly appealing to both players and casinos, as it may require no additional decision-making or separate betting. By offering a steady, incremental growth in the jackpot pool, this system helps casinos maintain player engagement and excitement.

### Mystery Jackpot Funding Technique #11—Dynamic Player Contributions

### Description and Implementation:

Dynamic Player Contributions allow players to voluntarily opt-in to contribute custom amounts to the Mystery Jackpot pool with each bet they place. For example, players may choose to contribute an additional $0.50, $1, or even more, on top of their regular wager. This system is implemented as an optional feature in both Live Dealer Game Tables (LDGTs) and Electronic Table Game Terminals (ETGTs), where players may select how much they wish to contribute to the jackpot pool before placing each bet.

This flexible contribution model gives players control over their level of participation in the Mystery Jackpot while offering a personalized and engaging gaming experience. The contributions are collected and added to the jackpot pool, which grows faster when more players opt to contribute higher amounts.

### Benefits to Players:

Players benefit from the flexibility and control provided by Dynamic Player Contributions. They may decide how much they want to contribute to the jackpot with each wager, depending on their budget and risk tolerance. This system also allows players to feel more involved in the jackpot's growth, knowing that their contributions play a direct role in increasing the potential prize. For players seeking more engagement, this method offers a deeper level of interaction with the game, as they may adjust their contributions based on their betting strategy and preferences.

### Benefits to Casinos:

Casinos benefit from the increased player engagement and flexibility offered by this system. By giving players the option to contribute dynamic amounts, casinos may encourage higher participation in the jackpot pool, leading to faster growth and more excitement. This method also allows casinos to cater to a broader range of players, from casual gamblers who opt for smaller contributions to high-rollers who choose to contribute larger amounts. The customization aspect of the system enhances the overall player experience, leading to longer gaming sessions and increased bet volumes.

### Example Walk-Through Scenario:

Ms. Wu, a frequent player at a high-stakes blackjack table in Macau, is offered the option to contribute dynamically to the Mystery Jackpot pool before placing her bets. On her first hand, she chooses to contribute an additional $1 on top of her regular $50 bet. As the game progresses, Ms. Wu increases her contributions to $5 per hand, excited by the growing jackpot displayed on the casino's large monitors.

Meanwhile, at another table, Mr. Huang, a more conservative player, opts to contribute just $0.50 per hand, satisfied with the ability to participate at his own pace. Both players enjoy the flexibility of the system, which allows them to tailor their contributions based on their personal preferences and bankroll. As more players choose to contribute dynamic amounts, the jackpot pool grows rapidly, creating an atmosphere of excitement and anticipation across the casino floor.

### Example System Procedural Flow:

1. Player Bet Placement:
   Players place their bets and are given the option to contribute an additional amount to the jackpot pool.

The system records the regular bet and the selected contribution.
2. Contribution Customization:
   Players select their desired contribution amount (e.g., $0.50, $1, $5), which is added to the total wager before the game round begins.
3. Contribution to Jackpot Pool:
   The selected contribution is directed to the Mystery Jackpot pool, and the main wager is applied to the game.
4. Casino Server Data Update:
   The contribution data is sent to the casino server, where the jackpot pool is updated in real-time and displayed on monitors throughout the casino.
5. Jackpot Pool Growth:
   As more players opt for dynamic contributions, the jackpot pool grows rapidly, creating increased player excitement.
6. Jackpot Eligibility and Payout:
   When the jackpot is triggered, the system verifies player contributions and awards the prize accordingly.

### Noteworthy Aspects and Features:

The Dynamic Player Contributions system stands out for its flexibility and player-centric design, allowing players to control how much they contribute to the jackpot pool. This level of customization enhances the overall gaming experience, encouraging players to engage more deeply with the game and jackpot. The system's ability to accommodate a wide range of contribution amounts ensures that both high-stakes and casual players may participate in the jackpot, fostering a sense of inclusivity and excitement. This method's adaptability makes it an attractive option for casinos looking to offer a personalized gaming experience that caters to a diverse player base.

### Mystery Jackpot Funding Technique #12—Promotional Game Rounds

### Description and Implementation:

The Promotional Game Rounds technique involves scheduling specific game rounds where a percentage of all bets placed during the round are directed to the Mystery Jackpot pool. These promotional rounds may be announced in advance or triggered at random intervals throughout the day, offering players an additional incentive to participate during these special rounds. This method leverages time-limited promotions to drive higher betting volumes and build excitement around the jackpot.

During each promotional round, the casino allocates a portion (e.g., 10%) of all wagers placed across participating Live Dealer Game Tables (LDGTs) and Electronic Table Game Terminals (ETGTs) to the jackpot pool. The increased contributions during these rounds allow the jackpot to grow significantly in a short period, generating more interest and player participation.

### Benefits to Players:

Players benefit from Promotional Game Rounds by having the opportunity to contribute more significantly to the jackpot during these special events. The time-limited nature of the rounds adds excitement and urgency, encouraging players to place higher bets or participate more actively during the promotional period. Players also appreciate the increased potential for larger jackpots as contributions spike during these rounds, offering a chance to win bigger prizes. The announcement of these promotional rounds creates anticipation, drawing players back to the tables at specific times.

### Benefits to Casinos:

Casinos benefit from increased player engagement and higher betting volumes during Promotional Game Rounds. The time-limited nature of the promotion encourages players to place larger bets and participate more actively, leading to increased contributions to the jackpot pool. This method also allows casinos to create targeted promotions around specific times of day or special events, driving traffic to the tables and enhancing the overall atmosphere. By offering these promotional rounds, casinos may maintain player interest and excitement, leading to longer gaming sessions and higher revenue.

### Example Walk-Through Scenario:

At a popular casino in Macau, the casino announces a series of Promotional Game Rounds for the evening. During these rounds, 10% of all bets placed at participating blackjack and baccarat tables will be contributed to the Mystery Jackpot pool. Players like Ms. Chen and Mr. Lau, eager to take advantage of the promotion, increase their usual bets, knowing that a larger portion of their wagers will go toward the growing jackpot.

As the promotional rounds begin, the tables are filled with excited players, all placing higher-than-usual bets in anticipation of the jackpot growth. The casino's monitors display the rapidly increasing jackpot total, creating a buzz on the casino floor. By the end of the night, the jackpot has grown substantially, thanks to the promotional contributions, and players are eagerly awaiting the chance to trigger the jackpot.

### Example System Procedural Flow:

1. Promotional Round Announcement:
   The casino schedules and announces the promotional game rounds, informing players that a percentage of all bets during the round will contribute to the jackpot.
2. Player Participation:
   During the promotional round, players place their bets as usual at participating LDGTs and ETGTs.

The system tracks all bets placed during the promotional period.
3. Contribution Allocation:
   A predefined percentage (e.g., 10%) of all bets placed during the round is automatically directed to the Mystery Jackpot pool.
4. Casino Network Data Transmission:
   The contribution data is sent to the casino's central server, where the jackpot pool is updated in real-time.
5. Jackpot Pool Growth:
   The jackpot pool grows significantly during the promotional rounds, and the updated total is displayed on monitors throughout the casino.
6. Jackpot Eligibility and Payout:
   If the jackpot is triggered, the system verifies the contributions and distributes the prize accordingly.

### Noteworthy Aspects and Features:

The Promotional Game Rounds technique is an innovative way to boost player engagement and contributions to the Mystery Jackpot pool in a short time. By scheduling specific rounds where contributions are increased, casinos may create a sense of urgency and excitement, driving higher betting volumes and player participation. The time-limited nature of these rounds encourages players to take action, while the larger contributions during these periods help the jackpot grow faster than usual. This method is particularly effective in high-traffic casinos like those in Macau, where players respond well to promotional events and time-sensitive opportunities.

### Mystery Jackpot Funding Technique #13—Time-Based Increment Funding

### Description and Implementation:

The Time-Based Increment Funding method gradually increases contributions to the Mystery Jackpot pool based on the duration of a player's gameplay. For every specific time interval a player remains active at a Live Dealer Game Table (LDGT) or Electronic Table Game Terminal (ETGT), a fixed amount is automatically contributed to the Mystery Jackpot. This system rewards long play sessions by consistently contributing to the jackpot at predefined intervals, such as every 5 or 10 minutes.

This method is particularly effective in engaging players over extended periods, as it offers an incentive for prolonged participation. The time-based contributions may be fixed or proportional to the player's current bet size, meaning that higher stakes players may contribute more to the jackpot at each interval.

### Benefits to Players:

Players benefit from the Time-Based Increment Funding system by knowing that their continued participation actively contributes to the jackpot's growth. The more time they spend playing, the larger the contribution made on their behalf. This technique adds a passive element to jackpot contributions, meaning players don't need to place additional bets or change their game strategy to participate. It also provides a sense of achievement, as players feel they are building toward a larger jackpot just by remaining at the table for longer periods. This system may also appeal to those who enjoy extended gameplay and want to see a direct result from their time investment.

### Benefits to Casinos:

Casinos benefit by encouraging longer player engagement with this system. Since the jackpot grows incrementally based on the time players spend at the table, casinos may increase overall game participation and keep tables and ETGTs occupied for longer. Additionally, Time-Based Increment Funding fosters a sense of ongoing excitement as players realize that their presence at the table is actively contributing to a growing prize pool. This method creates an environment where players are incentivized to remain in the game, extending playtime and, consequently, the overall revenue from bets placed during longer sessions.

### Example Walk-Through Scenario:

At a bustling Macau casino, Ms. Leong has been playing at a blackjack table for 30 minutes. Under the Time-Based Increment Funding system, every 10 minutes of continuous play automatically contributes $1 from her session to the Mystery Jackpot pool. By the time she reaches the 30-minute mark, $3 has been added to the jackpot on her behalf. Meanwhile, at a nearby ETGT, Mr. Ho has been playing for 50 minutes, with similar incremental contributions being added to the same jackpot pool.

As more players remain engaged, the jackpot pool grows steadily. While Ms. Leong doesn't have to actively increase her bets, she knows that simply by continuing to play, she is participating in building a larger jackpot. This encourages her to stay longer at the table, where the excitement of the steadily increasing jackpot motivates her to keep playing.

### Example System Procedural Flow:

1. Player Session Start:
   Players begin their gaming session at either an LDGT or ETGT. The system tracks the start time of each session.
2. Time-Based Trigger:
   For each predefined time interval (e.g., every 10 minutes), the system checks if the player is still active in the game. If the player is active, a set contribution (e.g., $1) is deducted from the table's jackpot allocation and added to the Mystery Jackpot pool.
3. Contribution Allocation:
   The system directs the incremented amount to the jackpot pool, ensuring that every player session actively contributes to the prize.
4. Real-Time Jackpot Update:
   The casino network updates the jackpot pool total in real-time, displaying the current amount on monitors throughout the casino.
5. Jackpot Trigger and Eligibility Check:
   When the jackpot is triggered, the system verifies that the player has met the required time-based criteria (e.g., continuous gameplay) and distributes the prize accordingly.
6. Jackpot Pool Reset:
   After the jackpot is awarded, the system resets the pool and continues collecting time-based increments from ongoing player sessions.

### Noteworthy Aspects and Features:

Time-Based Increment Funding is novel in its ability to passively accumulate contributions over time, encouraging longer player sessions. By linking jackpot contributions to time spent at the table rather than bet size, this system appeals to a wide range of players, regardless of their wagering habits. It provides casinos with a consistent stream of contributions while promoting extended gameplay, creating a win-win scenario for both the players and the casino. The technique's simplicity, combined with its ability to engage players for longer periods, makes it an appealing feature in high-traffic environments like Macau.

### Mystery Jackpot Funding Technique #14—Player Win Percentage Contribution

### Description and Implementation:

The Player Win Percentage Contribution system allocates a portion of a player's winnings from each game round to the Mystery Jackpot pool. For example, after a player wins a hand in blackjack or baccarat, a small percentage (e.g., 2%) of their winnings is contributed directly to the jackpot. This method encourages players to remain engaged with the game, knowing that each win, while rewarding them financially, also helps grow the shared jackpot pool.

The contribution amount is automatically deducted by the system once the player's winnings are calculated, ensuring a seamless process that does not interrupt gameplay. This method works well in both Live Dealer Game Tables (LDGTs) and Electronic Table Game Terminals (ETGTs), where bet results and winnings may be easily tracked in real-time.

### Benefits to Players:

Players benefit from Player Win Percentage Contribution as it allows them to participate in the jackpot without any additional effort. Each time they win, a portion of their winnings is automatically contributed to the pool, giving them a sense of satisfaction that their success is helping build a larger prize. The contribution percentage is usually small enough not to detract significantly from their overall earnings, while still providing meaningful growth to the jackpot. This method adds an extra layer of engagement, as players know that winning individual hands also brings them closer to the potential of winning a much larger jackpot.

### Benefits to Casinos:

Casinos benefit from this system by ensuring that a percentage of all player winnings contributes to the jackpot, creating a continuous stream of funding. The method fosters player excitement, as they are directly contributing to the prize with each win. By making contributions automatic, the casino ensures that the jackpot grows steadily without requiring players to take any additional actions. This system also enhances player retention, as players feel rewarded for winning, while simultaneously participating in the larger jackpot pool.

### Example Walk-Through Scenario:

At a baccarat table in a popular Macau casino, Ms. Wong wins a hand and receives a payout of $200. Under the Player Win Percentage Contribution system, 2% of her winnings ($4) is automatically contributed to the Mystery Jackpot pool. The deduction happens seamlessly, and Ms. Wong continues to play, knowing that her win has helped grow the jackpot.

At a nearby blackjack table, Mr. Li wins a $500 hand, and $10 is similarly directed into the jackpot. Over the course of the session, with multiple players winning hands and making small contributions, the jackpot pool grows rapidly. The players continue to compete against the house, excited by both their individual winnings and the growing jackpot they are helping to build.

### Example System Procedural Flow:

1. Player Win Calculation:
   When a player wins a hand or game, the system calculates their total winnings and determines the appropriate percentage to contribute to the jackpot (e.g., 2%).
2. Automatic Deduction:
   The system automatically deducts the contribution amount from the player's winnings and allocates it to the Mystery Jackpot pool.
3. Data Transmission to Casino Server:
   The winnings and contribution data are sent to the casino's central server, where the jackpot pool is updated in real-time.
4. Real-Time Jackpot Display:
   The updated jackpot pool is displayed on monitors, allowing players to see the growing prize pool.
5. Jackpot Trigger:
   The system continuously checks for jackpot-triggering events. When the jackpot is triggered, the prize is distributed based on predefined eligibility rules.
6. Jackpot Reset and Continuation:
   After the jackpot is awarded, the pool resets, and contributions from player wins continue to accumulate.

### Noteworthy Aspects and Features:

The Player Win Percentage Contribution technique provides a seamless, player-friendly way to contribute to the jackpot while keeping players engaged with their individual game outcomes. By linking contributions to player success, this method creates a positive feedback loop, where players feel rewarded for both their personal wins and their contribution to a larger prize. The system's automatic deduction and real-time updates make it easy to implement, while the steady stream of contributions ensures that the jackpot grows consistently. This technique is particularly effective in competitive gaming environments like those in Macau, where players are motivated by both individual wins and the potential for larger communal prizes.

### Mystery Jackpot Funding Technique #15—Ante-Based Jackpot Contributions

### Description and Implementation:

The Ante-based Jackpot Contributions technique involves automatically directing a portion of the ante in games like poker or blackjack to the Mystery Jackpot pool. Each time a player places an ante to participate in a round, a small fixed percentage (e.g., 5%) of the ante is allocated to the jackpot fund. This method is ideal for games where antes are a standard part of the betting process, allowing for a steady stream of contributions to the jackpot without requiring players to place additional side bets or take any extra actions.

In both Live Dealer Game Tables (LDGTs) and Electronic Table Game Terminals (ETGTs), the system automatically calculates and deducts the jackpot contribution from each ante, ensuring smooth gameplay without any disruptions. This funding technique is particularly well-suited for games that have consistent rounds and a high volume of players, leading to rapid growth of the jackpot.

### Benefits to Players:

Players benefit from the Ante-based Jackpot Contributions method because they are automatically participating in the Mystery Jackpot each time they place their ante. This system may require no additional betting decisions, making it simple and hassle-free. Players appreciate that a portion of their required ante contributes to the jackpot pool, giving them a sense of involvement without altering their specific gameplay strategy. This technique also appeals to players who enjoy consistent and predictable contributions to the jackpot, as they know exactly how much is being allocated from each ante.

### Benefits to Casinos:

For casinos, the Ante-based Jackpot Contributions technique ensures a steady stream of funding for the jackpot pool, driven by mandatory antes placed by players at the start of each round. This method provides a reliable contribution model that grows the jackpot consistently, encouraging players to stay at the table and continue placing antes. Since the contribution is automatically deducted, there is no need for players to make additional side bets, reducing friction and streamlining gameplay. The predictable and ongoing nature of ante-based contributions helps casinos maintain a consistently attractive jackpot pool, driving player interest and participation.

### Example Walk-Through Scenario:

At a poker table in a bustling Macau casino, players like Mr. Zhou and Ms. Zhang place their required $10 antes to participate in the next round. Under the Ante-based Jackpot Contributions system, 5% of each ante ($0.50) is automatically directed to the Mystery Jackpot pool. As more players join the game and place their antes, the contributions steadily accumulate, growing the jackpot without any need for additional player action.

Throughout the poker session, players continue to place antes each round, with a portion of each ante contributing to the jackpot. By the end of the night, the jackpot pool has grown substantially, fueled by the consistent flow of ante-based contributions. The players are excited by the potential to win the jackpot, knowing that their regular game participation has helped build the prize.

### Example System Procedural Flow:

1. Ante Placement:
   Players place their required antes at the beginning of each round. The system tracks each ante and determines the contribution amount (e.g., 5%).
2. Contribution Calculation:
   The system automatically deducts the contribution from each player's ante and allocates it to the Mystery Jackpot pool.
3. Real-Time Jackpot Update:
   The contribution data is sent to the casino's central server, where the jackpot pool is updated and displayed on monitors throughout the casino.
4. Player Eligibility Check:
   The system monitors player participation through their ante contributions, ensuring that all players who place an ante are eligible for the jackpot.
5. Jackpot Trigger and Payout:
   When the jackpot is triggered, the system verifies player eligibility and distributes the prize accordingly.
6. Jackpot Reset and Continuation:
   After the jackpot is awarded, the pool resets, and the ante-based contributions continue with each new round.

### Noteworthy Aspects and Features:

The Ante-based Jackpot Contributions method provides a straightforward and effective way to grow the jackpot pool through regular, mandatory player contributions. By integrating the jackpot contribution into the existing ante structure, this system may require no additional player actions or decisions, making it easy to implement and manage. The consistent flow of contributions ensures that the jackpot grows predictably, creating a sense of anticipation and excitement among players. This method is particularly well-suited for high-traffic, ante-based games like poker, where the steady accumulation of contributions leads to large, attractive jackpots.

### Mystery Jackpot Funding Technique #16—High Roller Pool Contribution

### Description and Implementation:

The High Roller Pool Contribution technique is designed specifically for high-stakes players, where a portion of large, high-value bets is directed into a separate, premium Mystery Jackpot pool. This method caters to high rollers who place larger wagers and seek the opportunity to win exclusive, high-value jackpots. For example, if a player places a bet over a certain threshold, such as $500, a percentage of that bet (e.g., 5%) is automatically allocated to a special high roller jackpot pool. This pool is separate from the regular Mystery Jackpot and is available only to players who meet the high-stakes contribution criteria.

This system is ideal for casinos that want to attract and reward high rollers while offering them an exclusive jackpot experience. It may be implemented across both Live Dealer Game Tables (LDGTs) and Electronic Table Game Terminals (ETGTs), where the system tracks high-value bets and automatically contributes a portion to the premium jackpot pool.

### Benefits to Players:

High-stakes players benefit from the High Roller Pool Contribution system by gaining access to an exclusive jackpot that is reserved for those placing larger bets. This method appeals to high rollers who want to participate in premium prize pools with fewer competitors. The high-value nature of the contributions means that the jackpot may grow quickly, offering the potential for significant payouts. Additionally, high rollers appreciate the prestige and exclusivity of being part of a special jackpot pool, tailored specifically for their level of play.

### Benefits to Casinos:

Casinos benefit from this technique by encouraging larger bets from high rollers, which directly increases both the regular game revenue and the contributions to the premium jackpot pool. By offering an exclusive jackpot for high-stakes players, casinos may attract and retain VIP customers who seek larger, more prestigious prizes. The High Roller Pool Contribution system also adds a layer of exclusivity to the casino experience, making high rollers feel valued and appreciated. This method may lead to increased betting volumes and longer play sessions among high-stakes players, resulting in higher overall revenue for the casino.

### Example Walk-Through Scenario:

At a high-stakes baccarat table in a luxury Macau casino, Mr. Cheng, a well-known high roller, places a $1,000 bet. Under the High Roller Pool Contribution system, 5% of his bet ($50) is automatically directed into the exclusive high roller Mystery Jackpot pool. This premium pool is reserved for players like Mr. Cheng, who place bets above a certain threshold. As the night progresses, other high rollers at the table, including Ms. Liu, also contribute to the premium jackpot with their large wagers.

Throughout the session, the high roller jackpot pool grows quickly due to the substantial contributions from each large bet. The players are excited by the potential for a massive payout, knowing that their participation in the high roller pool offers them a chance at an exclusive, life-changing prize.

### Example System Procedural Flow:

1. High-Stakes Bet Placement:
   Players at the high-stakes tables place large bets that meet the minimum threshold for participation in the high roller jackpot pool (e.g., $500).
2. Contribution Calculation:
   The system calculates a fixed percentage (e.g., 5%) of each qualifying bet and allocates it to the premium Mystery Jackpot pool.
3. Premium Pool Update:
   The contribution data is sent to the casino's central server, where the exclusive high roller jackpot pool is updated and displayed on monitors in the VIP gaming areas.
4. Eligibility Check:
   The system tracks player participation through their high-stakes bets, ensuring that only those who meet the contribution criteria are eligible for the premium jackpot.
5. Jackpot Trigger and Payout:
   When the high roller jackpot is triggered, the system verifies eligibility and distributes the prize exclusively to the qualifying high roller players.
6. Jackpot Pool Reset:
   After the premium jackpot is awarded, the pool resets, and contributions from high-stakes bets continue to accumulate for the next jackpot round.

### Noteworthy Aspects and Features:

The High Roller Pool Contribution system provides a unique and prestigious jackpot experience tailored specifically for high-stakes players. By offering an exclusive jackpot pool, casinos may attract and retain high rollers who seek larger prizes and a more exclusive gaming experience. This system fosters a sense of competition and prestige among high-stakes players, while the substantial contributions from large bets lead to rapid jackpot growth. The method's focus on premium, high-value prizes makes it an ideal option for VIP players in luxury casinos, particularly in markets like Macau, where high rollers play a significant role in driving revenue.

Mystery Jackpot Funding Technique #17—Progressive Wager Matching

### Description and Implementation:

The Progressive Wager Matching technique involves the casino matching a percentage of players' progressive wager contributions toward the Mystery Jackpot pool. Each time a player places a bet on a progressive side wager-such as a bonus bet on top of their regular wager-a percentage of that side bet is matched by the casino and added to the jackpot pool. For instance, if a player places a $5 progressive side bet, the casino may match 20% of that amount, contributing an additional $1 to the jackpot pool. This approach accelerates the growth of the jackpot by leveraging both player contributions and casino-matched funds.

This technique may be implemented across various Live Dealer Game Tables (LDGTs) and Electronic Table Game Terminals (ETGTs) that offer progressive wagers. The casino system automatically tracks the side wagers and applies the matching contribution whenever a progressive bet is placed.

### Benefits to Players:

Players benefit from the Progressive Wager Matching system as it enhances their participation in the jackpot pool without requiring them to increase their bets. The matching contributions from the casino add extra value to their side wagers, making their contributions more impactful in building the jackpot. Players are also incentivized to place progressive side bets more frequently, knowing that their wagers are matched, leading to faster jackpot growth and a greater chance of triggering a substantial payout.

### Benefits to Casinos:

Casinos benefit from this method by encouraging players to place more side wagers, which directly increases the overall betting volume. The matching system also fosters a sense of generosity from the casino, as players perceive the casino as actively contributing to the jackpot. The Progressive Wager Matching system drives player engagement and extended gameplay by making progressive side wagers more appealing, which increases revenue from both regular wagers and the matched jackpot contributions. Furthermore, casinos may strategically adjust the matching percentage to optimize their contributions while maintaining profitability.

### Example Walk-Through Scenario:

At a roulette table in a Macau casino, Ms. Fang places a $10 progressive side bet, hoping to participate in the rapidly growing Mystery Jackpot pool. Under the Progressive Wager Matching system, the casino automatically matches 20% of her side bet, contributing an additional $2 to the jackpot pool. Ms. Fang is excited to see that her contribution has more impact due to the casino's matching policy.

As more players at the table follow suit, placing their progressive wagers, the casino continues to match a portion of each bet. Mr. Chen, another player, places a $25 progressive wager, and the casino matches 20%, contributing $5 to the jackpot. Over time, the combined contributions from players and the casino drive the jackpot to grow significantly faster than it would through player contributions alone.

### Example System Procedural Flow:

1. Player Wager Placement:
   Players place their progressive side bets at an LDGT or ETGT. The system tracks these side wagers in real-time.
2. Casino Matching Contribution:
   For each progressive bet placed, the system calculates a percentage match (e.g., 20%) from the casino and adds the matching contribution to the Mystery Jackpot pool.
3. Data Transmission to Casino Server:
   Both the player's contribution and the casino's matching contribution are transmitted to the central casino server, where the jackpot pool is updated.
4. Real-Time Jackpot Display:
   The updated jackpot total is displayed on casino monitors, showing both player and casino contributions.
5. Jackpot Trigger and Payout:
   When the jackpot is triggered, the system verifies the contributions and distributes the prize accordingly, ensuring that players who placed progressive bets are eligible for the payout.
6. Jackpot Reset:
   After the jackpot is awarded, the pool resets, and the matching system continues for subsequent progressive side wagers.

### Noteworthy Aspects and Features:

Progressive Wager Matching is unique in that it enhances the value of player contributions by including casino-matched funds. This system increases player excitement and engagement by providing an added incentive for placing side wagers, which accelerates the growth of the jackpot. The ability for casinos to adjust the matching percentage makes this system flexible and adaptable to different gaming environments. The combined contributions from both players and the casino create a faster-growing jackpot, which is particularly appealing in high-stakes markets like Macau, where players seek larger and more lucrative prizes.

### Mystery Jackpot Funding Technique #18—External Sponsorship Contributions

### Description and Implementation:

The External Sponsorship Contributions technique involves partnering with external sponsors, such as luxury brands, entertainment companies, or corporate advertisers, who contribute to the Mystery Jackpot pool as part of promotional campaigns. These contributions are typically tied to specific marketing events or promotions, where sponsors agree to fund a portion of the jackpot in exchange for brand visibility within the casino or during gameplay. For example, a luxury car brand may sponsor a high-profile baccarat tournament and contribute $10,000 to the jackpot, with their branding prominently displayed throughout the event.

This system allows casinos to generate significant funds for the Mystery Jackpot without relying solely on player contributions. Sponsorship agreements are integrated into the casino's overall marketing strategy, and contributions may be displayed on monitors, digital interfaces, or through direct engagement with players.

### Benefits to Players:

Players benefit from the External Sponsorship Contributions technique by gaining access to a significantly larger jackpot pool without needing to increase their own contributions. The involvement of external sponsors may lead to massive increases in the jackpot, creating more excitement and anticipation. Players may also enjoy additional perks from sponsors, such as special rewards or promotional offers that enhance the overall gaming experience. This technique creates a more dynamic and immersive gaming environment, where external brands play a role in enhancing the value of the jackpot.

### Benefits to Casinos:

Casinos benefit from this technique by generating additional funding for the Mystery Jackpot without impacting their own profit margins. External sponsorships provide casinos with the opportunity to collaborate with high-profile brands, which may enhance the casino's prestige and attract more patrons. The external contributions also allow casinos to offer larger jackpots, which draws more players to the tables and increases overall engagement. Moreover, the casino may strategically align sponsorships with notable events or promotions, further enhancing the appeal of both the jackpot and the associated brand.

### Example Walk-Through Scenario:

At a renowned Macau casino, a high-profile poker tournament is being held, sponsored by a luxury watch brand. As part of the sponsorship agreement, the watch brand contributes $50,000 to the Mystery Jackpot pool. Throughout the tournament, players like Mr. Huang and Ms. Zhao are excited by the prospect of winning a significantly larger jackpot, fueled by the sponsor's contribution.

The sponsor's branding is displayed prominently on screens around the casino and during digital interactions on the Electronic Table Game Terminals (ETGTs). Players receive promotional offers related to the sponsor's products, adding another layer of engagement to the experience. By the end of the tournament, the combined contributions from players and the sponsor have created one of the largest jackpots the casino has ever seen, creating a memorable event for all participants.

### Example System Procedural Flow:

1. Sponsorship Agreement:
   The casino negotiates an agreement with an external sponsor, determining the amount of the contribution and the terms of brand visibility during the promotional event.
2. Sponsorship Contribution:
   The sponsor's contribution is added to the Mystery Jackpot pool, either as a lump sum or as part of an ongoing promotional campaign.
3. Casino Network Update:
   The sponsor's contribution is reflected in the jackpot pool total, and the casino network updates the jackpot amount in real-time across all participating tables and ETGTs.
4. Brand Promotion:
   The sponsor's branding is displayed throughout the casino, on monitors, digital signage, and during player interactions with the game terminals.
5. Jackpot Growth:
   As the sponsored event progresses, additional player contributions add to the jackpot pool, which continues to grow based on both player wagers and sponsor funding.
6. Jackpot Trigger and Payout:
   When the jackpot is triggered, the system verifies eligibility and distributes the prize, acknowledging the sponsor's contribution during the payout announcement.

### Noteworthy Aspects and Features:

The External Sponsorship Contributions technique introduces a new revenue stream for funding the Mystery Jackpot, allowing casinos to offer larger and more attractive jackpots without solely relying on player contributions. This method also enhances the overall casino experience by integrating external brands into gameplay, creating a mutually beneficial relationship between the sponsor and the casino. The ability to align sponsorships with high-profile events makes this technique especially appealing in luxury markets like Macau, where premium brands seek to engage with affluent clientele.

### Mystery Jackpot Funding Technique #19—Charity-Based Contributions

### Description and Implementation:

The Charity-Based Contributions technique allows players to voluntarily direct a portion of their winnings or bets toward both the Mystery Jackpot pool and a designated charitable cause. Each time a player wins a round or places a bet, they are given the option to contribute a percentage (e.g., 2%) of their winnings or wager to the jackpot, with a matching percentage donated to a preselected charity. This technique not only contributes to the jackpot's growth but also aligns the gaming experience with social responsibility, offering players the opportunity to support a good cause while playing.

This method may be implemented in both Live Dealer Game Tables (LDGTs) and Electronic Table Game Terminals (ETGTs), where players are prompted to choose their contribution preferences before or after placing bets. The charity-based contributions are integrated into the casino's broader social responsibility initiatives, enhancing the casino's reputation and fostering a positive relationship with players.

### Benefits to Players:

Players benefit from the Charity-Based Contributions system by being able to support a charitable cause while participating in the Mystery Jackpot. This method appeals to players who appreciate the opportunity to give back and make a difference, even while enjoying their favorite games. The charity-based contributions also allow players to feel more connected to their community, as a portion of their winnings or bets goes toward a cause they care about. This technique provides an added emotional incentive to engage in gameplay, as players know that their contributions are helping others while also building the jackpot.

### Benefits to Casinos:

Casinos benefit from this method by enhancing their brand image and demonstrating a commitment to corporate social responsibility. The Charity-Based Contributions system may attract players who are socially conscious and more to engage with a casino that supports charitable causes. This method also helps casinos differentiate themselves from competitors by offering a gaming experience that aligns with positive social impact. Additionally, the charity-based contributions may generate good publicity for the casino, attracting more patrons who are interested in supporting both the jackpot and charitable efforts.

### Example Walk-Through Scenario:

At a popular casino in Macau, Mr. Lee is playing baccarat at a Live Dealer Game Table. After winning a hand, he is prompted by the casino's system to contribute 2% of his winnings to the Mystery Jackpot, with a matching 2% directed to a local children's charity. Mr. Lee agrees, and $4 of his $200 win is split between the jackpot and the charity.

As the game progresses, other players at the table, including Ms. Liu, also opt to contribute a portion of their winnings to the charity and jackpot. By the end of the session, the combined contributions from the players have helped build the jackpot pool while supporting a meaningful cause. The casino's system tracks and reports the charitable donations, fostering goodwill among players and the broader community.

### Example System Procedural Flow:

1. Player Win or Bet Placement:
   When a player wins a hand or places a bet, the system prompts them to contribute a percentage of their winnings or wager to both the Mystery Jackpot and a designated charity.
2. Player Contribution Selection:
   The player selects their preferred contribution amount (e.g., 2%) and confirms their participation in the charity-based system.
3. Contribution Allocation:
   The system automatically splits the contribution, directing one portion to the Mystery Jackpot pool and the other to the charity.
4. Real-Time Jackpot and Charity Update:
   The casino server updates the jackpot pool and tracks the total charitable donations, displaying the current jackpot amount and donation totals on casino monitors.
5. Charity Branding:
   The charity being supported is prominently featured on monitors and signage around the casino, raising awareness of the cause.
6. Jackpot Trigger and Payout:
   When the jackpot is triggered, the system verifies eligibility and distributes the prize, acknowledging the charity-based contributions during the payout announcement.

### Noteworthy Aspects and Features:

The Charity-Based Contributions technique combines gaming with philanthropy, creating a more meaningful and socially responsible casino experience. This method enhances the player's emotional connection to the game by allowing them to contribute to a charitable cause while building the jackpot. Casinos benefit from the positive publicity and improved brand image associated with charitable giving, which may attract a broader, more socially conscious clientele. By integrating charity into the gaming process, this technique helps casinos foster a positive community presence and build long-term relationships with their patrons.

### Mystery Jackpot Funding Technique #20—Event-Based Jackpot Funding

### Description and Implementation:

The Event-Based Jackpot Funding technique ties Mystery Jackpot contributions to specific casino events, such as tournaments, themed nights, or special promotions. During these events, a portion of all bets or entry fees is allocated to the Mystery Jackpot pool. For example, during a high-stakes poker tournament, 5% of the entry fees may be directed to the jackpot. Alternatively, during a themed night, a percentage of all wagers placed at participating tables or Electronic Table Game Terminals (ETGTs) may be contributed to the jackpot.

This technique leverages special events to generate significant funding for the jackpot in a short period. The contributions are often tied to the event's promotion, encouraging players to participate in both the event and the jackpot-building process. Event-based funding may be implemented as a one-time contribution or as a recurring feature during regular events.

### Benefits to Players:

Players benefit from the Event-Based Jackpot Funding method by gaining access to larger jackpots during special events. These events often create a more exciting and festive atmosphere, where players are more motivated to participate, knowing that a portion of their bets is contributing to the jackpot. The event-based nature of the contributions adds a layer of exclusivity and excitement, as players feel that they are part of a limited-time opportunity to win a larger prize.

### Benefits to Casinos:

Casinos benefit from this technique by tying jackpot growth to specific promotions and events, which drives player traffic and participation. The event-based funding method creates a sense of urgency and excitement, encouraging players to attend and engage with the event. This method also allows casinos to build momentum around certain promotions, attracting more patrons and increasing overall revenue. Additionally, the ability to create themed or exclusive events linked to the jackpot enhances the casino's brand image and provides a unique gaming experience that differentiates the casino from its competitors.

### Example Walk-Through Scenario:

At a high-end Macau casino, a special “Millionaire Poker Night” tournament is being held. The event draws high-rollers and competitive players from around the region, and as part of the promotion, 5% of each entry fee is directed to the Mystery Jackpot pool. Mr. Zhang, an avid poker player, is excited to participate in the tournament, knowing that his entry fee is helping build a large jackpot that will be available to all participants.

Throughout the night, players at the poker tables contribute to the jackpot through their entry fees and wagers. Meanwhile, other casino patrons participating in themed games, such as blackjack and roulette, are also contributing to the same jackpot, creating a massive prize pool by the end of the event. The excitement of the tournament, combined with the growing jackpot, keeps players engaged and eager to participate in future event-based promotions.

### Example System Procedural Flow:

1. Event Announcement:
   The casino announces a special event or promotion, informing players that a percentage of all bets or entry fees will contribute to the Mystery Jackpot during the event.
2. Player Participation:
   Players register for the event or participate in designated games, and the system tracks their bets or entry fees.
3. Contribution Allocation:
   A predefined percentage of each bet or fee is automatically allocated to the jackpot pool, which grows as the event progresses.
4. Casino Network Data Update:
   The contribution data is sent to the casino's central server, where the jackpot pool is updated in real-time and displayed on monitors throughout the event.
5. Event Branding and Promotion:
   The event's branding and promotional materials are prominently displayed, encouraging players to continue contributing to the jackpot during the event.
6. Jackpot Trigger and Payout:
   When the jackpot is triggered, the system verifies eligibility and distributes the prize to the winner(s), announcing the event's success and the total jackpot amount.

### Noteworthy Aspects and Features:

The Event-Based Jackpot Funding technique creates an exciting, time-limited opportunity for players to contribute to and potentially win a large jackpot. By linking the jackpot to special events, casinos may generate significant contributions in a short period, creating a sense of urgency and anticipation. This method also enhances the overall atmosphere of the casino, providing players with a unique and memorable experience. Event-based funding allows casinos to leverage promotions to increase player traffic and participation, ultimately driving higher revenue and engagement.

### Mystery Jackpot Funding Technique #21—Casino Revenue Allocation

### Description and Implementation:

The Casino Revenue Allocation technique involves designating a percentage of the casino's overall revenue, separate from individual bets, to fund the Mystery Jackpot pool. Rather than relying solely on player contributions, the casino allocates a portion of its profits or daily revenues (e.g., from food and beverage sales, hotel stays, or other non-gaming services) directly to the jackpot. This method allows the casino to maintain a consistent jackpot growth rate while potentially offering larger jackpots to attract more players.

This technique may be implemented at any time by the casino management, often used as a promotional tool to boost player interest in specific events or game types. The contributions are typically automated through the casino's financial management system, ensuring a steady and seamless flow of funds into the jackpot pool, making it a reliable method to increase jackpot sizes.

### Benefits to Players:

Players benefit from Casino Revenue Allocation because it leads to larger and faster-growing jackpots without requiring any additional contributions on their part. This system is appealing because players may see the jackpot pool grow simply by participating in regular casino activities, knowing that the casino is also directly contributing to the prize. Larger jackpots also increase the excitement and draw more attention to the game, encouraging players to stay engaged longer for a chance at the bigger prize.

### Benefits to Casinos:

Casinos benefit from this system by creating a buzz around larger jackpot prizes, which may draw more players to the tables. By leveraging non-gaming revenue sources like hotel services or restaurant sales, casinos may grow the jackpot without diminishing their gaming profits. Additionally, this technique provides an opportunity for the casino to control jackpot growth during slower periods, creating more consistent player engagement across the board. The promotional aspect of allocating casino revenue to the jackpot may also be used to attract new players and boost the casino's overall brand reputation.

### Example Walk-Through Scenario:

At a popular Macau casino, the management team decides to allocate 1% of the day's total non-gaming revenue to the Mystery Jackpot pool. This includes proceeds from hotel room bookings, restaurant sales, and spa services. On a busy holiday weekend, the hotel generates $500,000 in non-gaming revenue, resulting in a $5,000 contribution to the jackpot pool.

Mr. Chen, a regular blackjack player, is excited to see the jackpot rapidly increase throughout the weekend. As he and other players continue playing, the jackpot grows, driven by both player wagers and the casino's daily revenue allocation. By the end of the weekend, the jackpot has reached a significant amount, creating heightened excitement among players who are eager for a chance to win.

### Example System Procedural Flow:

1. Revenue Calculation:
   The casino's financial management system calculates total non-gaming revenue (e.g., from hotel services, food and beverage sales, etc.) at regular intervals (daily or weekly).
2. Allocation Percentage:
   A predefined percentage of this revenue (e.g., 1%) is allocated to the Mystery Jackpot pool, and the system directs the funds accordingly.
3. Data Transmission to Casino Server:
   The allocated revenue contribution is sent to the central casino server, which updates the jackpot pool in real-time.
4. Real-Time Jackpot Update:
   The new jackpot total is displayed on monitors throughout the casino, attracting attention and encouraging player participation.
5. Jackpot Growth:
   As non-gaming revenue continues to be generated, the jackpot pool grows steadily, creating excitement among players.
6. Jackpot Trigger and Payout:
   When the jackpot is triggered, the system verifies the player's eligibility and awards the prize accordingly.

### Noteworthy Aspects and Features:

Casino Revenue Allocation is an innovative technique that allows casinos to grow their jackpots by leveraging non-gaming revenue streams. This system helps casinos offer larger jackpots, which may draw more players and generate excitement across the casino floor. By tying the jackpot to non-gaming activities, the casino diversifies its funding sources, allowing for more consistent jackpot growth without relying solely on player contributions. This method is particularly effective in large resort-style casinos where non-gaming revenue is a significant part of the overall business, making it an attractive option for venues in locations like Macau.

### Mystery Jackpot Funding Technique #22—Multigame Contribution Pooling

### Description and Implementation:

The Multigame Contribution Pooling technique involves collecting contributions for the Mystery Jackpot from a variety of games throughout the casino, creating a shared jackpot pool. This method allows for a unified jackpot that grows based on contributions from different types of games, such as blackjack, baccarat, roulette, and even slot machines. Every time a player places a bet in any of the participating games, a small percentage (e.g., 1%-2%) of their wager is funneled into the same jackpot pool, regardless of the game type.

This technique is highly flexible and may be applied to both Live Dealer Game Tables (LDGTs) and Electronic Table Game Terminals (ETGTs). The system tracks all participating games, ensuring that each game contributes to the overall jackpot pool. By pooling contributions across multiple games, the jackpot grows more quickly, creating a larger and more exciting prize.

### Benefits to Players:

Players benefit from Multigame Contribution Pooling because it allows them to participate in a larger jackpot regardless of which game they are playing. Whether they are playing blackjack, baccarat, or roulette, all of their bets contribute to the same jackpot, giving them multiple opportunities to win. The shared nature of the jackpot also fosters a sense of excitement among players, as they see the prize pool grow rapidly due to contributions from across the casino. This system appeals to both casual players and high rollers, as all participants have a chance to win the unified jackpot.

### Benefits to Casinos:

Casinos benefit from Multigame Contribution Pooling by offering a more attractive and rapidly growing jackpot, which draws players to a variety of games. By pooling contributions from multiple games, the casino may build a larger jackpot more quickly, creating more excitement on the casino floor. This technique also encourages cross-game participation, as players may be more to try different games knowing that they are all contributing to the same jackpot. Additionally, the flexibility of this system allows casinos to include a wide range of games, optimizing the use of existing gaming infrastructure to drive higher engagement and revenue.

### Example Walk-Through Scenario:

At a major Macau casino, players across various game types are contributing to the same Mystery Jackpot pool through the Multigame Contribution Pooling system. Mr. Tan, playing roulette, places a $100 bet, and 2% of his wager is automatically allocated to the shared jackpot. Meanwhile, at a nearby blackjack table, Ms. Li places a $50 bet, with 1% of her wager going toward the same jackpot pool.

As the night progresses, more players across different games continue to contribute to the growing jackpot. The casino's large jackpot monitors display the current prize, showing rapid growth as bets come in from multiple game types. By the end of the evening, the shared jackpot has reached a significant amount, with players from various games excited about their chance to win.

### Example System Procedural Flow:

1. Player Bet Placement:
   Players place bets at LDGTs and ETGTs across various games, and the system tracks the contributions for each game.
2. Contribution Calculation:
   A percentage of each wager (e.g., 1%-2%) is automatically deducted and added to the shared Mystery Jackpot pool.
3. Data Transmission to Casino Server:
   The contribution data from all participating games is transmitted to the central casino server, where the jackpot pool is updated in real-time.
4. Real-Time Jackpot Update:
   The current jackpot total is displayed on monitors throughout the casino, showing contributions from various games.
5. Jackpot Growth:
   As more bets are placed across multiple games, the jackpot pool grows rapidly, creating excitement among players.
6. Jackpot Trigger and Payout:
   When the jackpot is triggered, the system verifies eligibility and distributes the prize to the winning player, regardless of the game they were playing.

### Noteworthy Aspects and Features:

Multigame Contribution Pooling offers a highly flexible and engaging way to build a large, shared jackpot across multiple games. This technique encourages players to explore different games, knowing that they all contribute to the same prize pool. The ability to collect contributions from various games ensures rapid jackpot growth, making it an attractive option for casinos seeking to boost player engagement and excitement. This system's inclusivity appeals to a wide range of players, from casual gainers to high-stakes gamblers, making it particularly effective in high-traffic gaming environments like Macau.

### Mystery Jackpot Funding Technique #23—Bonus Round Trigger Contribution

### Description and Implementation:

The Bonus Round Trigger Contribution technique directs a portion of the winnings or bets from special bonus rounds or side games to the Mystery Jackpot pool. In games that feature bonus rounds-such as free spins in slot machines or bonus hands in table games-a percentage of the winnings from these rounds is automatically contributed to the jackpot. For example, in a slot game, if a player triggers a bonus round that awards free spins, a small portion of their bonus winnings may be allocated to the jackpot pool.

This method capitalizes on the excitement of bonus rounds, creating additional engagement by linking them to the growing jackpot. It may be implemented in both Electronic Gaming Machines (EGMs) and Electronic Table Game Terminals (ETGTs) that feature bonus games. The contribution is seamless and automatic, ensuring that the jackpot grows every time a bonus round is triggered.

### Benefits to Players:

Players benefit from Bonus Round Trigger Contribution by having their bonus round winnings contribute to a growing jackpot, adding extra excitement to their gameplay. Knowing that bonus rounds are tied to the Mystery Jackpot provides players with additional incentive to participate in games with bonus features. This system also enhances the overall gaming experience, as players feel that they are actively contributing to a communal jackpot every time they win in a bonus round.

### Benefits to Casinos:

Casinos benefit from this technique by creating an additional stream of contributions to the Mystery Jackpot.

Bonus rounds are already a major draw for players, and by linking them to the jackpot, casinos may further enhance player engagement and excitement. This system encourages players to participate in games with bonus features, increasing overall betting volume and driving revenue. The automatic contribution from bonus round winnings ensures that the jackpot grows steadily, creating a larger and more attractive prize pool for players.

### Example Walk-Through Scenario:

Ms. Zhang is playing a popular slot machine at a Macau casino when she triggers a bonus round that awards her 10 free spins. During the bonus round, she wins $500, and under the Bonus Round Trigger Contribution system, 2% of her winnings ($10) is automatically contributed to the Mystery Jackpot pool.

Meanwhile, at an ETGT blackjack game, Mr. Wong triggers a special bonus hand, winning an extra $200. A portion of his winnings is also directed to the jackpot pool. As more players trigger bonus rounds across different games, the jackpot pool grows rapidly, creating excitement among players eager to win both in the bonus rounds and the larger communal jackpot.

### Example System Procedural Flow:

1. Bonus Round Trigger:
   Players trigger a bonus round in a game (e.g., free spins in a slot machine or a bonus hand in a table game). The system tracks the bonus round and calculates any winnings.
2. Contribution Calculation:
   A predefined percentage of the player's bonus round winnings is automatically allocated to the Mystery Jackpot pool.
3. Data Transmission to Casino Server:
   The contribution data from bonus rounds is sent to the central casino server, where the jackpot pool is updated in real-time.
4. Real-Time Jackpot Display:
   The updated jackpot total is displayed on monitors throughout the casino, showing contributions from various bonus rounds.
5. Jackpot Growth:
   As more bonus rounds are triggered across different games, the jackpot pool grows, attracting more player interest.
6. Jackpot Trigger and Payout:
   When the jackpot is triggered, the system verifies eligibility and distributes the prize to the winning player, regardless of the game they were playing.

### Noteworthy Aspects and Features:

Bonus Round Trigger Contribution leverages the popularity of bonus rounds to drive additional contributions to the Mystery Jackpot. This technique enhances the excitement of bonus features, as players know that their winnings are helping to grow the communal jackpot. By linking bonus rounds to the jackpot, casinos may increase player engagement and participation in games with bonus features, ultimately driving higher revenue and larger jackpots. This system is easy to implement across both EGMs and ETGTs, making it a versatile and effective option for casinos looking to enhance their jackpot offerings.

### Mystery Jackpot Funding Technique #24—Game-Specific Pool Contributions

### Description and Implementation:

The Game-Specific Pool Contributions technique involves dedicating a portion of all bets placed on a specific game or game type to a separate Mystery Jackpot pool. Unlike other techniques that aggregate contributions across multiple games, this method creates a jackpot pool that is unique to a particular game. For example, a baccarat table may have its own exclusive Mystery Jackpot pool, funded entirely by contributions from baccarat bets.

This technique works well for popular games where players prefer a more focused, game-specific jackpot. Contributions are automatically deducted from each bet placed on the designated game, and the pool grows only through the activity at that specific game. This method may be applied to both Live Dealer Game Tables (LDGTs) and Electronic Table Game Terminals (ETGTs), where the system tracks all bets and contributions for the game-specific jackpot.

### Benefits to Players:

Players benefit from Game-Specific Pool Contributions by participating in a jackpot that is exclusive to their favorite game. This method appeals to players who enjoy playing specific games and want to contribute to a jackpot that is directly tied to their chosen game. The exclusivity of the jackpot pool increases the chances of winning for players who regularly participate in the designated game, creating a more focused and engaging experience.

### Benefits to Casinos:

Casinos benefit from Game-Specific Pool Contributions by creating dedicated jackpot pools that enhance player loyalty and engagement with specific games. This system allows casinos to offer tailored jackpot experiences for different types of games, increasing player participation and betting volume. The exclusivity of the game-specific jackpot also allows casinos to differentiate their offerings, attracting players who are particularly loyal to certain games like baccarat, blackjack, or roulette.

### Example Walk-Through Scenario:

At a high-stakes baccarat table in a Macau casino, Mr. Li places a $100 bet, and 2% of his wager is automatically allocated to the baccarat-specific Mystery Jackpot pool. Unlike other jackpots that are shared across multiple games, this pool is exclusive to baccarat players. As more players like Mr. Li continue to place their bets, the baccarat-specific jackpot grows rapidly.

Throughout the session, the jackpot pool remains tied exclusively to baccarat bets, creating excitement among the players who know that their chances of winning the game-specific jackpot are higher than in a shared pool. By the end of the night, the baccarat-specific jackpot has grown significantly, drawing even more players to the table.

### Example System Procedural Flow:

1. Player Bet Placement:
   Players place bets on the designated game (e.g., baccarat), and the system tracks the contributions for the game-specific jackpot pool.
2. Contribution Calculation:
   A percentage of each bet (e.g., 2%) is automatically deducted and added to the game-specific Mystery Jackpot pool.
3. Data Transmission to Casino Server:
   The contribution data is transmitted to the central casino server, where the game-specific jackpot pool is updated in real-time.
4. Real-Time Jackpot Display:
   The updated jackpot total for the specific game is displayed on monitors near the designated game, attracting player attention.
5. Jackpot Growth:
   As more bets are placed on the specific game, the jackpot pool grows, creating excitement among players.
6. Jackpot Trigger and Payout:
   When the jackpot is triggered, the system verifies eligibility and distributes the prize to the winning player from the designated game.

### Noteworthy Aspects and Features:

Game-Specific Pool Contributions provides a focused and exclusive jackpot experience for players who prefer certain games. This technique enhances player loyalty and engagement by offering a jackpot that is tied directly to their favorite game, increasing the chances of winning for those who participate regularly. Casinos benefit from creating tailored jackpot experiences that appeal to different player segments, making this method particularly effective in environments where certain games, like baccarat, have a strong following. The exclusivity and excitement generated by game-specific jackpots make this technique a powerful tool for increasing player retention and overall engagement.

### Mystery Jackpot Funding Technique #25—Rolling Bet Contribution

### Description and Implementation:

The Rolling Bet Contribution technique involves rolling over a portion of a losing player's bet into the Mystery Jackpot pool. When a player loses a wager at a Live Dealer Game Table (LDGT) or Electronic Table Game Terminal (ETGT), a small percentage of their losing bet (e.g., 5%) is directed to the jackpot. This system capitalizes on the inevitable outcome of losing bets, using them to continuously fuel the jackpot growth.

Rolling bet contributions are automatically deducted from losing bets, ensuring that the jackpot pool increases steadily even when players are not winning. This system may be implemented across various game types, including blackjack, baccarat, roulette, and poker, where losing wagers are common but consistent.

### Benefits to Players:

Players benefit from Rolling Bet Contributions by knowing that even when they lose a round, a portion of their lost wager still contributes to a potential future win through the growing jackpot. This system helps to soften the blow of losing by keeping the player engaged with the prospect of winning a large jackpot. Additionally, players appreciate that their contributions from losing bets are helping to build a communal prize pool that they may eventually have a chance to win.

### Benefits to Casinos:

Casinos benefit from this system by ensuring continuous funding for the jackpot pool, regardless of the game's outcomes. The Rolling Bet Contribution technique provides a steady stream of contributions, ensuring that the jackpot grows quickly and consistently. By using a portion of losing wagers to fund the jackpot, casinos may build larger prizes without directly impacting their overall revenue. This system also encourages players to keep betting, as they feel their losing bets are not entirely wasted and may contribute to a future jackpot win.

### Example Walk-Through Scenario:

At a baccarat table in a bustling Macau casino, Mr. Leung places a $100 bet on the banker but loses the hand. Under the Rolling Bet Contribution system, 5% of his lost bet ($5) is automatically directed into the Mystery Jackpot pool. Similarly, Ms. Chan, who placed a $50 bet on the player and lost, also contributes $2.50 from her losing wager to the jackpot.

Throughout the session, as more players lose bets, the jackpot pool steadily grows from these rolling contributions. Players at the table, even though experiencing losses, remain hopeful and engaged, knowing that their losing wagers are contributing to a growing prize pool. By the end of the evening, the jackpot has reached a significant amount, building excitement among the players.

### Example System Procedural Flow:

1. Player Bet Placement:
   Players place their bets on various games at the LDGT or ETGT. The system tracks both winning and losing outcomes.
2. Loss Detection and Contribution:
   When a player loses a wager, the system calculates a percentage (e.g., 5%) of the lost bet to be contributed to the Mystery Jackpot pool.
3. Contribution Allocation:
   The system automatically deducts the calculated contribution from the losing wager and adds it to the jackpot pool.
4. Real-Time Jackpot Update:
   The casino server updates the jackpot pool in real-time, displaying the new total on monitors across the casino floor.
5. Continuous Jackpot Growth:
   As more losing bets occur, the jackpot pool grows steadily, fueled by contributions from these losses.
6. Jackpot Trigger and Payout:
   When the jackpot is triggered, the system verifies eligibility and awards the prize to the winning player, resetting the pool for continued growth.

### Noteworthy Aspects and Features:

The Rolling Bet Contribution technique provides a novel way to grow the jackpot by using losing wagers as a consistent funding source. This system ensures that even during periods of player losses, the jackpot pool continues to grow, creating a sense of continuous progress. Players remain engaged with the game, knowing that their losing bets still contribute to a potential future win. For casinos, this technique offers a reliable and sustainable method for increasing jackpot sizes without directly affecting profits, making it an attractive option for driving long-term player engagement and excitement.

### Mystery Jackpot Funding Technique #26—Loyalty-Based Jackpot Funding

### Description and Implementation:

The Loyalty-Based Jackpot Funding technique leverages a casino's player loyalty program to contribute to the Mystery Jackpot pool. Each time a player earns loyalty points through gameplay-either at Live Dealer Game Tables (LDGTs) or Electronic Table Game Terminals (ETGTs)—a portion of those points is converted into a monetary contribution toward the jackpot. For instance, if a player earns 100 loyalty points during a session, 10 of those points may be automatically transferred into the jackpot fund.

This method integrates the casino's loyalty system into jackpot funding, encouraging regular players to participate in building the jackpot. Contributions are tied directly to a player's loyalty activity, offering an additional layer of engagement and reward.

### Benefits to Players:

Players benefit from Loyalty-Based Jackpot Funding by having their loyalty points contribute to a growing jackpot, which adds an extra level of excitement to their regular gameplay. Knowing that their continued participation in the casino's loyalty program directly helps build the jackpot encourages players to remain loyal and engaged. This system also provides players with a sense of involvement in the communal jackpot, as their loyalty is being rewarded not just through traditional perks, but also by contributing to a potentially life-changing prize.

### Benefits to Casinos:

Casinos benefit from this technique by fostering player loyalty and long-term engagement. By linking loyalty points to jackpot contributions, casinos may encourage players to stay longer and participate more actively in the loyalty program. This system helps drive overall casino revenue by incentivizing players to keep earning points, which in turn funds the jackpot. Additionally, it strengthens the relationship between the player and the casino, as players feel more connected to the jackpot and the broader loyalty rewards system.

### Example Walk-Through Scenario:

At a large Macau casino, Ms. Wong, a regular player, earns 500 loyalty points over the course of a weekend of blackjack and roulette play. Under the Loyalty-Based Jackpot Funding system, 10% of her loyalty points (50 points) are automatically converted into a monetary contribution to the Mystery Jackpot pool. Other players at the casino, including Mr. Liu, who earns 300 loyalty points during the same weekend, contribute a portion of their points as well.

As players continue to accumulate loyalty points, their collective contributions steadily grow the jackpot pool. By the end of the weekend, the jackpot has increased significantly, fueled by loyalty-based contributions from regular players. Ms. Wong, excited to see her loyalty points directly impacting the jackpot, feels a greater sense of connection to the game and the casino.

### Example System Procedural Flow:

1. Loyalty Points Accumulation:
   Players earn loyalty points during gameplay at LDGTs and ETGTs, with the system tracking their point totals.
2. Conversion to Jackpot Contribution:
   A portion of the earned loyalty points (e.g., 10%) is automatically converted into a monetary contribution to the Mystery Jackpot pool.
3. Contribution Allocation:
   The system directs the converted points to the jackpot fund, ensuring that the pool grows as players accumulate more loyalty points.
4. Casino Server Update:
   The contribution data is transmitted to the central casino server, where the jackpot pool is updated in real-time and displayed to players.
5. Jackpot Growth and Engagement:
   As players continue to earn loyalty points, the jackpot pool grows steadily, creating excitement and encouraging continued gameplay.
6. Jackpot Trigger and Payout:
   When the jackpot is triggered, the system verifies player eligibility and awards the prize accordingly.

### Noteworthy Aspects and Features:

The Loyalty-Based Jackpot Funding technique uniquely integrates the casino's loyalty program into the jackpot system, offering players an additional way to contribute to the prize pool. By linking loyalty points to jackpot funding, casinos may incentivize longer play sessions and greater player engagement. This system appeals to regular players who are already invested in the loyalty program, offering them a new and exciting reward for their continued participation. It also helps casinos build player retention, as players feel more connected to the jackpot and are motivated to earn more points.

### Mystery Jackpot Funding Technique #27—Jackpot Funded by Casino Promotions

### Description and Implementation:

The Jackpot Funded by Casino Promotions technique ties specific casino promotions directly to the funding of the Mystery Jackpot. When the casino runs promotional events, such as “double points” weekends, free play bonuses, or special tournaments, a portion of the promotion's value is allocated to the jackpot pool. For instance, during a double points weekend, the casino may allocate 5% of the total promotional rewards earned by players to the jackpot, or during a special tournament, a portion of the entry fees may be directed to the jackpot.

This method leverages the casino's promotional calendar to build the jackpot, ensuring that special events and promotions actively contribute to the growth of the prize pool. The contributions may be automated through the casino's event management system, allowing the jackpot to grow seamlessly in conjunction with the promotion.

### Benefits to Players:

Players benefit from Jackpot Funded by Casino Promotions by having the opportunity to participate in promotions that simultaneously build the Mystery Jackpot. This method enhances the value of promotional events, as players know that their participation in a promotion not only offers immediate rewards but also contributes to a larger communal prize. The excitement of special promotions is amplified by the connection to the jackpot, making the entire casino experience more engaging and rewarding.

### Benefits to Casinos:

Casinos benefit from this system by driving player participation in promotional events, which boosts overall engagement and revenue. By tying promotions to the jackpot, the casino creates a sense of urgency and excitement around both the event and the growing prize pool. This technique also helps casinos optimize their promotional calendar by ensuring that every event contributes to the jackpot, building anticipation among players. The increased traffic and participation during promotional events lead to higher revenues, while the jackpot serves as an additional draw to attract players.

### Example Walk-Through Scenario:

At a luxury casino in Macau, the casino runs a “double points” weekend promotion, where players earn double the usual loyalty points for every bet they place. Under the Jackpot Funded by Casino Promotions system, 5% of the total loyalty points earned by players during the weekend is allocated to the Mystery Jackpot pool. Mr. Lim, a frequent player, earns 2,000 loyalty points during the promotion, and 100 points are converted into a monetary contribution to the jackpot.

Meanwhile, the casino also runs a special poker tournament during the weekend, with a portion of the entry fees contributing to the jackpot. As players participate in both the tournament and the double points promotion, the jackpot grows rapidly, creating excitement throughout the casino. By the end of the weekend, the jackpot has reached an impressive size, fueled by contributions from the promotional activities.

### Example System Procedural Flow:

1. Promotion Announcement:
   The casino announces a special promotion or event, informing players that a portion of the promotion's value will contribute to the Mystery Jackpot.
2. Player Participation:
   Players engage with the promotion, earning rewards (e.g., double points) or entering tournaments, while the system tracks their promotional activity.
3. Contribution Calculation:
   The system calculates the portion of the promotion's value (e.g., 5% of total points earned or tournament entry fees) to be contributed to the jackpot.
4. Contribution Allocation:
   The system automatically allocates the calculated amount to the Mystery Jackpot pool, which grows in real-time.
5. Real-Time Jackpot Display:
   The updated jackpot total is displayed on monitors throughout the casino, showing players the impact of the promotion on the growing prize pool.
6. Jackpot Trigger and Payout:
   When the jackpot is triggered, the system verifies eligibility and awards the prize to the winning player.

### Noteworthy Aspects and Features:

The Jackpot Funded by Casino Promotions technique effectively leverages promotional events to grow the jackpot pool, creating a seamless link between promotions and jackpot excitement. This system encourages higher player participation in promotions, as players see the immediate benefits of the promotion alongside the long-term potential of a large jackpot. For casinos, this technique helps optimize promotional efforts, driving traffic and revenue while ensuring the jackpot grows consistently. By tying promotions to the jackpot, casinos may create more excitement and engagement across their entire promotional calendar.

### Mystery Jackpot Funding Technique #28—Cross-Casino Jackpot Network

### Description and Implementation:

The Cross-Casino Jackpot Network technique involves linking multiple casinos within a regional or global network to contribute to a shared Mystery Jackpot pool. Contributions come from players across different casino locations, allowing the jackpot to grow significantly faster than if it were limited to a single casino. For example, players in Macau, Las Vegas, and Singapore may all contribute to and compete for the same jackpot, creating a massive prize pool.

This method is enabled through sophisticated casino network systems that track and pool contributions from multiple locations. The system ensures that each casino contributes a percentage of player wagers from designated games, with all contributions being funneled into the shared jackpot pool. The Cross-Casino Jackpot Network is particularly effective for large casino chains or partnerships looking to create high-profile jackpots that attract global attention.

### Benefits to Players:

Players benefit from the Cross-Casino Jackpot Network by gaining access to a much larger jackpot than they would at a single casino. The ability to compete for a global jackpot adds an extra layer of excitement and prestige to the game, as players know that they are part of a worldwide competition for a life-changing prize. This system also encourages players to participate in different casinos within the network, as they may continue contributing to and chasing the same jackpot across multiple locations.

### Benefits to Casinos:

Casinos benefit from this technique by creating an extremely attractive jackpot that draws players from all over the world. The Cross-Casino Jackpot Network helps casinos build brand loyalty, as players are incentivized to visit different locations within the network to continue participating in the same jackpot. This system also generates significant publicity, as the global nature of the jackpot attracts attention from a wide range of players. Additionally, the ability to link contributions from multiple locations ensures that the jackpot grows rapidly, creating more excitement and engagement across the entire network.

### Example Walk-Through Scenario:

At a network of luxury casinos in Macau, Las Vegas, and Singapore, players are contributing to a shared Mystery Jackpot pool through the Cross-Casino Jackpot Network system. Mr. Wong, playing baccarat at a casino in Macau, places a $200 bet, with 2% of his wager contributing to the global jackpot. Meanwhile, Ms. Johnson, playing blackjack at a partner casino in Las Vegas, contributes 1% of her bet to the same jackpot pool.

As more players across the network of casinos place their bets, the jackpot grows rapidly, reaching a massive prize pool by the end of the week. Players in all locations are excited by the prospect of winning the global jackpot, knowing that their contributions are part of a larger, worldwide competition.

### Example System Procedural Flow:

1. Player Bet Placement:
   Players at multiple casinos within the network place their bets on designated games, and the system tracks their contributions to the shared jackpot.
2. Cross-Casino Contribution Pooling:
   A percentage of each wager (e.g., 1%-2%) from all participating casinos is automatically added to the global Mystery Jackpot pool.
3. Data Transmission to Central Server:
   Contribution data from each casino is transmitted to a central server, which manages the shared jackpot pool and updates the total in real-time.
4. Global Jackpot Display:
   The updated jackpot total is displayed on monitors at all participating casinos, creating a sense of global competition and excitement.
5. Jackpot Growth:
   As more players place bets across the network, the jackpot grows rapidly, attracting more players from different locations.
6. Jackpot Trigger and Payout:
   When the jackpot is triggered, the system verifies eligibility and distributes the prize to the winning player, regardless of which casino they were playing at.

### Noteworthy Aspects and Features:

The Cross-Casino Jackpot Network technique offers a groundbreaking way to create massive, global jackpots that appeal to players across multiple locations. By pooling contributions from casinos in different regions, this system ensures rapid jackpot growth and creates a sense of worldwide competition. Players are excited by the opportunity to win a global prize, while casinos benefit from increased player traffic and engagement across their entire network. This technique is particularly effective for large casino chains or partnerships looking to create a high-profile jackpot that attracts international attention.

### Mystery Jackpot Funding Technique #29—Time-Limited Jackpot Contributions

### Description and Implementation:

The Time-Limited Jackpot Contributions technique ties the funding of the Mystery Jackpot pool to specific time windows during which all player wagers contribute a percentage to the jackpot. For example, between 8 p.m. and 10 p.m. each day, 5% of all bets placed at Live Dealer Game Tables (LDGTs) and Electronic Table Game Terminals (ETGTs) is automatically funneled into the jackpot. This creates a time-sensitive dynamic, encouraging players to participate more actively during the designated period.

This method may be applied to any game type, and the contribution percentage may be adjusted depending on the promotion's goals. Time-limited contributions are often used to create excitement and urgency, as players are more to participate when they know their bets will have a direct and immediate impact on the growing jackpot pool.

### Benefits to Players:

Players benefit from Time-Limited Jackpot Contributions by having the opportunity to participate in a rapidly growing jackpot during specific hours. The limited-time aspect adds excitement and urgency, driving players to engage more frequently during the designated window. Knowing that a larger portion of their bets is contributing to the jackpot makes the gameplay experience more thrilling. Players may also feel they have a better chance of winning, as the pool grows quickly during these high-traffic periods.

### Benefits to Casinos:

Casinos benefit from this system by driving player engagement during slower periods or promoting special events with high participation. The time-limited nature of the contribution period encourages players to stay longer or return to the casino at specific times, increasing overall betting volume. This technique may also be used as part of a larger marketing campaign to boost traffic and excitement on the gaming floor. By concentrating jackpot contributions into a defined time window, casinos may ensure a significant and rapid increase in the jackpot, which in turn attracts more players.

### Example Walk-Through Scenario:

At a popular casino in Macau, the management team announces a daily Time-Limited Jackpot Contribution promotion where, between 7 p.m. and 9 p.m., 5% of all wagers placed on baccarat, blackjack, and roulette tables will contribute to the Mystery Jackpot pool. Mr. Wu, a regular player, decides to arrive early to take advantage of the promotion. He places a $200 bet on baccarat at 7:30 p.m., and $10 from his wager is directed into the jackpot pool.

During the same time window, other players across the casino are placing their bets, and a portion of each bet is similarly allocated to the jackpot. By the time the promotion ends at 9 p.m., the jackpot has grown significantly, creating a sense of excitement throughout the casino. Players who participated feel satisfied knowing they contributed to the larger prize, and many are eager to return the next day for another chance to participate.

### Example System Procedural Flow:

1. Promotion Setup:
   The casino sets a time window during which a portion of all player wagers will contribute to the Mystery Jackpot pool.
2. Player Bet Placement:
   During the specified time window, players place bets at LDGTs and ETGTs. The system tracks the amount of each wager and calculates the contribution percentage.
3. Contribution Allocation:
   A portion of each bet (e.g., 5%) is automatically allocated to the Mystery Jackpot pool.
4. Casino Server Update:
   The contribution data is transmitted to the central casino server, where the jackpot pool is updated in real-time throughout the time window.
5. Real-Time Jackpot Growth:
   The growing jackpot is displayed on monitors across the casino, encouraging more players to participate during the time-limited promotion.
6. Jackpot Trigger and Payout:
   When the jackpot is triggered, the system verifies eligibility and awards the prize. After the time-limited period ends, the pool continues to grow through regular contributions.

### Noteworthy Aspects and Features:

Time-Limited Jackpot Contributions effectively drive player engagement by creating a sense of urgency and excitement around a specific time window. This technique may be used to attract players during traditionally slower periods or to enhance the excitement of special events. By concentrating contributions into a short, defined period, casinos may ensure rapid jackpot growth, which draws more attention to the game. The time-sensitive nature of the promotion encourages players to return to the casino regularly, increasing overall betting volume and player retention.

### Mystery Jackpot Funding Technique #30—Dynamic Wager-Based Contributions

### Description and Implementation:

The Dynamic Wager-Based Contributions technique adjusts the contribution percentage to the Mystery Jackpot pool based on the size of the player's bet. Larger bets contribute a higher percentage, while smaller bets contribute less, creating a dynamic system where players who place bigger wagers have a more significant impact on the jackpot's growth. For example, a player placing a $500 bet may contribute 5% of their wager, while a player placing a $50 bet may contribute 2%.

This system may be applied across both Live Dealer Game Tables (LDGTs) and Electronic Table Game Terminals (ETGTs), and the contribution percentage may scale progressively based on wager size. The dynamic contribution model encourages high-stakes players to place larger bets, knowing that their contributions will have a more substantial impact on the jackpot pool.

### Benefits to Players:

Players benefit from Dynamic Wager-Based Contributions by having a direct influence on the growth of the jackpot based on the size of their bet. High rollers, in particular, are incentivized to place larger wagers, as their contributions help grow the jackpot more significantly. This system adds an extra layer of strategy to the game, as players may choose to increase their bets to have a larger stake in building the jackpot. Additionally, players appreciate the fairness of the system, knowing that their contributions are proportional to their bet size.

### Benefits to Casinos:

Casinos benefit from this system by encouraging higher betting volumes, especially from high-stakes players who want to have a more significant impact on the jackpot. The dynamic nature of the contributions ensures that larger bets drive faster jackpot growth, creating more excitement and engagement on the casino floor. This system also allows casinos to fine-tune the contribution percentages to optimize both player engagement and profitability, making it a flexible and adaptable option for various gaming environments.

### Example Walk-Through Scenario:

At a high-stakes blackjack table in a Macau casino, Mr. Lin places a $1,000 bet, knowing that under the Dynamic Wager-Based Contributions system, 5% of his wager ($50) will be added to the Mystery Jackpot pool. Meanwhile, at a nearby roulette table, Ms. Lee places a more modest $100 bet, contributing 2% ($2) to the same jackpot pool.

As the game progresses, the players see the jackpot grow rapidly, with larger wagers having a more significant impact. Mr. Lin, encouraged by his substantial contribution, decides to increase his next bet, hoping to drive the jackpot even higher. The excitement at both tables builds as players watch the jackpot total climb, knowing that their bets are directly influencing its growth.

### Example System Procedural Flow:

1. Player Bet Placement:
   Players place their wagers at LDGTs or ETGTs, and the system tracks the bet size for each player.
2. Dynamic Contribution Calculation:
   The system calculates the contribution percentage based on the size of the wager. Larger bets contribute a higher percentage, while smaller bets contribute a lower percentage.
3. Contribution Allocation:
   The system automatically deducts the calculated contribution from each wager and allocates it to the Mystery Jackpot pool.
4. Real-Time Jackpot Update:
   The contribution data is transmitted to the casino server, where the jackpot pool is updated in real-time and displayed to players.
5. Jackpot Growth:
   As larger wagers are placed, the jackpot pool grows rapidly, creating excitement among players.
6. Jackpot Trigger and Payout:
   When the jackpot is triggered, the system verifies eligibility and awards the prize, resetting the pool for continued contributions.

### Noteworthy Aspects and Features:

The Dynamic Wager-Based Contributions technique encourages players to place larger bets by tying the contribution percentage directly to wager size. This system appeals to high-stakes players who want to have a more substantial impact on the jackpot, while still allowing lower-stakes players to participate. The flexibility of the dynamic model allows casinos to optimize contribution percentages to drive player engagement and maximize revenue. This method ensures that the jackpot grows quickly, creating a more exciting and competitive gaming environment.

### Mystery Jackpot Funding Technique #31—Jackpot Contribution Thresholds

### Description and Implementation:

The Jackpot Contribution Thresholds technique introduces minimum bet thresholds that players must meet in order to contribute to the Mystery Jackpot pool. Only wagers that exceed a certain amount (e.g., $50 or $100) are eligible to contribute a percentage to the jackpot. This method encourages players to place larger bets to ensure they are participating in the jackpot funding, adding a layer of exclusivity to the jackpot pool.

The contribution threshold may vary depending on the game or promotion, and the system may be implemented across both Live Dealer Game Tables (LDGTs) and Electronic Table Game Terminals (ETGTs). By setting a minimum threshold, casinos may ensure that only higher-value wagers contribute to the jackpot, making the pool grow more quickly while encouraging higher betting levels.

### Benefits to Players:

Players benefit from Jackpot Contribution Thresholds by feeling a sense of exclusivity and reward when they place larger bets that qualify for jackpot contributions. This system appeals to more competitive players who enjoy the challenge of meeting the threshold and being part of a select group of contributors. The knowledge that their higher wagers are contributing to a communal jackpot creates a sense of camaraderie among high-stakes players, adding to the excitement of the game.

### Benefits to Casinos:

Casinos benefit from this system by encouraging players to place higher wagers to qualify for jackpot contributions. By setting a minimum threshold, the casino ensures that the jackpot pool is funded by larger bets, leading to more rapid growth. This system also helps the casino attract higher-stakes players, as they are more to meet the contribution requirements. The threshold system creates a more exclusive and competitive environment, driving engagement and revenue from both high-stakes and regular players.

### Example Walk-Through Scenario:

At a Macau casino, players at a high-stakes poker table are aware of the Jackpot Contribution Thresholds system, which may require a minimum bet of $100 to contribute to the Mystery Jackpot pool. Mr. Zhang places a $200 bet, ensuring that 5% of his wager ($10) is allocated to the jackpot. Meanwhile, Mr. Wong, placing a smaller $50 bet, does not qualify for the jackpot contribution, encouraging him to raise his bets in future rounds.

As the game progresses, players who meet the contribution threshold are excited to see the jackpot grow, knowing that they are part of a select group driving the pool's growth. The exclusivity of the contribution system encourages other players to increase their bets in order to qualify, leading to a more competitive and engaging gaming session.

### Example System Procedural Flow:

1. Player Bet Placement:
   Players place their wagers at LDGTs or ETGTs, and the system checks if the bet meets the minimum threshold for jackpot contribution.
2. Threshold Verification:
   If the wager meets the threshold (e.g., $100), the system calculates a percentage of the bet to be contributed to the jackpot pool.
3. Contribution Allocation:
   The system automatically allocates the calculated contribution to the Mystery Jackpot pool for qualifying bets.
4. Real-Time Jackpot Update:
   The casino server updates the jackpot pool in real-time, displaying the current total to players.
5. Jackpot Growth:
   As more players place qualifying bets, the jackpot pool grows, encouraging others to meet the contribution threshold.
6. Jackpot Trigger and Payout:
   When the jackpot is triggered, the system verifies eligibility and awards the prize to a qualifying player.

### Noteworthy Aspects and Features:

The Jackpot Contribution Thresholds technique creates a sense of exclusivity and competition among players by requiring a minimum bet to contribute to the jackpot pool. This system encourages players to place higher wagers, driving increased betting volumes and more rapid jackpot growth. The threshold system appeals to high-stakes players while still allowing regular players to participate in the game, making it an effective way for casinos to boost both engagement and revenue. The selective nature of the contribution system adds excitement and exclusivity to the gaming experience.

### Mystery Jackpot Funding Technique #32—Multiplier-Based Jackpot Contributions

### Description and Implementation:

The Multiplier-Based Jackpot Contributions technique introduces a multiplier system that increases the contribution percentage based on specific in-game achievements or milestones. For example, if a player wins three consecutive hands at a blackjack table or achieves a specific payout combination on a slot machine, their next bet may contribute double or triple the normal percentage to the Mystery Jackpot pool. This system rewards player success by allowing them to have a more significant impact on the jackpot growth during streaks of good fortune.

This technique may be implemented across both Live Dealer Game Tables (LDGTs) and Electronic Table Game Terminals (ETGTs), where the system automatically applies multipliers based on predefined conditions. By tying jackpot contributions to player performance, the casino creates a more dynamic and engaging gaming environment.

### Benefits to Players:

Players benefit from Multiplier-Based Jackpot Contributions by having their successful gameplay rewarded with a higher contribution to the jackpot. This system encourages players to continue playing when they are on a winning streak, knowing that their achievements may lead to a larger contribution to the jackpot. The multiplier system adds excitement and unpredictability to the game, as players look forward to unlocking higher contributions through their success.

### Benefits to Casinos:

Casinos benefit from this system by incentivizing longer play sessions and encouraging players to aim for specific achievements or milestones. The Multiplier-Based Jackpot Contributions system adds an extra layer of engagement, as players are motivated to continue playing in order to unlock larger contributions. This method also drives higher betting volumes, as players aim to maximize their contributions when they are on a winning streak. The dynamic nature of the multiplier system helps create a more exciting and competitive atmosphere on the gaming floor.

### Example Walk-Through Scenario:

At a blackjack table in a Macau casino, Ms. Zhou wins three consecutive hands, triggering the Multiplier-Based Jackpot Contributions system. On her next bet, instead of the usual 2% contribution to the Mystery Jackpot pool, the system applies a 3× multiplier, meaning 6% of her bet is allocated to the jackpot. Excited by the opportunity to make a larger contribution, Ms. Zhou increases her wager for the next round.

As the game progresses, other players at the table take note of the multiplier system and aim to trigger their own streaks of consecutive wins. The multiplier adds an extra layer of excitement to the game, as players are motivated to keep playing in order to unlock higher contributions to the jackpot. By the end of the session, the jackpot has grown significantly, fueled by both regular contributions and the boosted contributions from players on winning streaks.

### Example System Procedural Flow:

1. Player Bet Placement:
   Players place their bets at LDGTs or ETGTs, and the system tracks in-game achievements or milestones that may trigger the multiplier.
2. Multiplier Activation:
   When a player reaches a predefined achievement (e.g., consecutive wins or specific payouts), the system activates the multiplier for their next contribution.
3. Multiplier-Based Contribution Calculation:
   The system calculates the enhanced contribution based on the multiplier (e.g., 3× the normal contribution) and allocates it to the jackpot pool.
4. Real-Time Jackpot Update:
   The enhanced contribution is transmitted to the casino server, where the jackpot pool is updated in real-time and displayed to players.
5. Jackpot Growth:
   As more players unlock multipliers, the jackpot grows rapidly, creating excitement and engagement across the gaming floor.
6. Jackpot Trigger and Payout:
   When the jackpot is triggered, the system verifies eligibility and distributes the prize to the winning player.

### Noteworthy Aspects and Features:

The Multiplier-Based Jackpot Contributions technique adds an exciting and dynamic element to the game by tying larger contributions to player success. This system rewards players for achieving specific milestones or streaks, encouraging them to continue playing and increasing their stake in the jackpot. For casinos, the multiplier system drives longer play sessions and higher betting volumes, while creating a more engaging and competitive gaming environment. The unpredictability and excitement of unlocking larger contributions make this technique particularly appealing to players looking for a more interactive and rewarding gaming experience.

### Mystery Jackpot Funding Technique #33—Jackpot Ticket Purchase

### Description and Implementation:

The Jackpot Ticket Purchase technique allows players to purchase tickets specifically to participate in the Mystery Jackpot pool, separate from regular game wagers. Players may buy tickets directly from the casino or through the interface of Electronic Table Game Terminals (ETGTs) or Live Dealer Game Tables (LDGTs). The tickets, priced at different levels (e.g., $5, $10, or $20), directly contribute to the Mystery Jackpot pool, with each ticket giving the player a chance to win the jackpot when triggered.

This method provides an alternative funding stream for the jackpot by allowing players to contribute without affecting their regular gameplay. The ticketing system may be integrated with various promotions and offers, encouraging players to purchase multiple tickets for higher chances of winning.

### Benefits to Players:

Players benefit from Jackpot Ticket Purchase by gaining additional opportunities to participate in the jackpot without needing to alter their regular betting behavior. For those who enjoy the thrill of jackpots but may not be frequent players, the ability to buy tickets offers a way to get involved without having to engage in extended gameplay. Furthermore, the ticket purchase system may appeal to players who prefer structured contributions with a clear cost, knowing that their ticket purchase directly increases their odds of winning the jackpot.

### Benefits to Casinos:

Casinos benefit from this system by creating a direct revenue stream dedicated to funding the jackpot. The Jackpot Ticket Purchase method encourages additional spending from players, especially those who may not engage in regular high-stakes betting but still want to participate in the excitement of the jackpot. By offering tickets at multiple price points, casinos may attract a wide range of players, from casual participants to high-rollers. Additionally, the ticketing system may be linked to loyalty programs or special promotions, incentivizing players to buy more tickets.

### Example Walk-Through Scenario:

At a high-end casino in Macau, players are offered the opportunity to buy tickets for the Jackpot Ticket Purchase system. Mr. Lau, who prefers not to participate in high-stakes games but enjoys the excitement of jackpots, purchases two $10 tickets. Meanwhile, Ms. Chen, an avid baccarat player, buys five $20 tickets to maximize her chances of winning. The casino's ticket system automatically directs the proceeds from ticket sales into the Mystery Jackpot pool.

Throughout the evening, players continue to buy tickets, and the jackpot pool grows rapidly. The casino's monitors display the current total, showing how much has been contributed through ticket sales. By the end of the night, the jackpot has reached an impressive sum, creating excitement among both ticket holders and regular players who are eager for the chance to win.

### Example System Procedural Flow:

1. Ticket Purchase:
   Players are offered the option to purchase jackpot tickets at varying price levels (e.g., $5, $10, $20) via ETGTs, LDGTs, or from the casino directly.
2. Contribution Allocation:
   The system automatically directs 100% of the ticket sales into the Mystery Jackpot pool, which grows as more tickets are purchased.
3. Data Transmission to Casino Server:
   Ticket sales data are transmitted to the casino's central server, where the jackpot pool is updated in real-time and displayed to players.
4. Ticket Confirmation:
   Players receive a confirmation of their purchased tickets, either digitally through the gaming terminal or as physical tickets from the casino.
5. Jackpot Growth:
   As ticket purchases increase, the jackpot pool grows rapidly, creating excitement and anticipation across the casino floor.
6. Jackpot Trigger and Payout:
   When the jackpot is triggered, the system verifies the winning ticket holder and awards the prize accordingly, resetting the pool for continued growth.

### Noteworthy Aspects and Features:

The Jackpot Ticket Purchase system provides a straightforward and flexible way for players to participate in the Mystery Jackpot, appealing to both casual and high-stakes players. This method allows casinos to directly fund the jackpot through ticket sales while offering players a separate path to participate in the excitement. By setting various ticket price levels, casinos may attract a broad player base, from those seeking a low-cost entry to those who are willing to spend more for higher chances of winning. This system may be easily integrated with promotions and loyalty programs, adding additional layers of engagement.

### Mystery Jackpot Funding Technique #34—Group Bet Contribution

### Description and Implementation:

The Group Bet Contribution technique enables multiple players to collectively contribute to the Mystery Jackpot pool by pooling their bets. In this system, groups of players at Live Dealer Game Tables (LDGTs) or Electronic Table Game Terminals (ETGTs) may form a “group wager,” where a percentage of each player's bet is directed into the jackpot pool, and the group as a whole has a chance to win the jackpot if it is triggered.

The contribution percentage may vary based on the size of the group or the total wager amount. This technique promotes social interaction and teamwork among players, as they may strategize and contribute together to build the jackpot pool, knowing that they all stand to win collectively.

### Benefits to Players:

Players benefit from Group Bet Contribution by having the chance to increase their stake in the jackpot through collective contributions. This method encourages camaraderie and social interaction, as players work together to pool their bets for a shot at the jackpot. Additionally, players who may not typically place large individual bets may still participate in significant jackpot contributions by joining a group, making the system more inclusive and exciting.

### Benefits to Casinos:

Casinos benefit from this system by encouraging larger total wagers from groups of players, driving higher overall betting volumes. The Group Bet Contribution method enhances the social aspect of casino gaming, which may lead to longer play sessions and increased player retention. The system also allows casinos to create group-specific promotions or tournaments, further incentivizing players to participate as a team and driving more contributions to the jackpot pool.

### Example Walk-Through Scenario:

At a blackjack table in a Macau casino, four friends decide to participate in the Group Bet Contribution system. Each player places a $50 bet, with 3% of each bet ($6) being pooled into the Mystery Jackpot fund. Collectively, the group contributes $24 to the jackpot, and if the jackpot is triggered, the group wins as a whole and splits the prize.

As the game progresses, the group is excited to watch the jackpot grow, knowing that their collective bets have a direct impact. They continue placing group bets, strategizing together to maximize their chances of winning. By the end of the session, they have collectively contributed a substantial amount to the jackpot, creating a sense of teamwork and shared excitement.

### Example System Procedural Flow:

1. Group Formation:
   Players form a group at the LDGT or ETGT, agreeing to pool their bets for the purposes of contributing to the Mystery Jackpot pool.
2. Group Bet Placement:
   Each player places their individual bet, and the system calculates the total group wager and the percentage to be contributed to the jackpot pool.
3. Contribution Allocation:
   The system automatically allocates a percentage of the total group bet to the jackpot pool, updating the pool in real-time.
4. Casino Server Update:
   The contribution data is transmitted to the central casino server, where the jackpot pool is updated and displayed to players.
5. Group Interaction and Betting:
   Players continue placing group bets, strategizing together to maximize their chances of contributing more to the jackpot.
6. Jackpot Trigger and Payout:
   When the jackpot is triggered, the system verifies the group's contributions and awards the prize to the group, to be split equally among the members.

### Noteworthy Aspects and Features:

The Group Bet Contribution technique enhances the social and interactive aspects of casino gaming by encouraging players to pool their bets for a shared shot at the jackpot. This system promotes teamwork and camaraderie among players, driving longer play sessions and increasing engagement. For casinos, the group-based contribution model leads to higher overall betting volumes, as groups of players collectively contribute more than they would individually. This method is particularly appealing in environments where social gaming is popular, such as Macau's bustling casinos.

### Mystery Jackpot Funding Technique #35—Bonus Payout Contributions

### Description and Implementation:

The Bonus Payout Contributions technique directs a percentage of all bonus payouts from casino games into the Mystery Jackpot pool. Whenever a player wins a bonus payout-such as a free spin bonus on a slot machine or a bonus hand in a table game-a portion of their bonus winnings is automatically allocated to the jackpot. For example, if a player wins a $200 bonus, 5% of the bonus amount ($10) is contributed to the jackpot.

This system capitalizes on the popularity of bonus payouts across a variety of games, ensuring that the jackpot pool grows consistently as players continue to hit bonus rounds. The contributions are automated, making the process seamless for players and easy to manage for the casino.

### Benefits to Players:

Players benefit from Bonus Payout Contributions by knowing that their bonus wins not only reward them directly but also contribute to a larger communal jackpot. This system creates a sense of ongoing engagement, as players feel that every bonus win is helping to build a larger prize pool that they may potentially win later.

Additionally, players who frequently trigger bonus payouts may feel more connected to the growth of the jackpot, enhancing their overall excitement and investment in the game.

### Benefits to Casinos:

Casinos benefit from this system by using bonus payouts—an already engaging aspect of gameplay—to fund the jackpot pool consistently. The Bonus Payout Contributions method ensures that the jackpot grows quickly, particularly in games where bonus rounds are common. This technique also increases player retention, as players are motivated to continue playing in the hopes of triggering more bonus rounds, knowing that each bonus win helps fuel the jackpot.

### Example Walk-Through Scenario:

Ms. Ho is playing a popular slot machine at a Macau casino and triggers a free spin bonus round, winning $500. Under the Bonus Payout Contributions system, 5% of her bonus win ($25) is automatically allocated to the Mystery Jackpot pool. Similarly, Mr. Chu, playing blackjack at a nearby table, wins a $150 bonus hand, with 5% of his win ($7.50) also contributing to the jackpot.

As players across the casino continue to trigger bonus rounds and bonus payouts, the jackpot pool grows steadily. The contributions from these bonus payouts add up quickly, creating excitement among players as they see the jackpot total rise. By the end of the night, the jackpot has grown significantly, fueled by contributions from various bonus rounds across multiple games.

### Example System Procedural Flow:

1. Bonus Payout Trigger:
   Players trigger bonus payouts from slot machines, table games, or other casino games. The system tracks each bonus win and calculates the contribution percentage.
2. Contribution Allocation:
   A portion of each bonus payout (e.g., 5%) is automatically deducted and allocated to the Mystery Jackpot pool.
3. Casino Server Update:
   The contribution data is transmitted to the casino's central server, where the jackpot pool is updated in real-time and displayed to players.
4. Ongoing Bonus Contributions:
   As players continue to trigger bonus rounds and payouts, the jackpot pool grows, creating excitement and engagement among players.
5. Jackpot Trigger and Payout:
   When the jackpot is triggered, the system verifies eligibility and awards the prize, resetting the pool for continued contributions.

### Noteworthy Aspects and Features:

The Bonus Payout Contributions system leverages the natural excitement of bonus rounds to fuel the Mystery Jackpot. This method ensures consistent contributions to the jackpot pool, particularly in games where bonus rounds are frequent and popular. For players, the connection between their bonus payouts and the jackpot enhances their overall gaming experience, creating a sense of ongoing involvement in building the jackpot. For casinos, this technique offers a reliable and automated way to grow the jackpot pool, driving player engagement and retention.

### Mystery Jackpot Funding Technique #36—Linked Machine Contributions

### Description and Implementation:

The Linked Machine Contributions technique connects multiple slot machines or Electronic Table Game Terminals (ETGTs) to a single, shared Mystery Jackpot pool, with a portion of the bets placed on each machine contributing to the pool. This system allows a large network of gaming terminals to fund the jackpot simultaneously, leading to rapid growth. Players on any linked machine may trigger the jackpot, creating excitement across all terminals involved.

This method is particularly effective in high-traffic casinos where multiple machines are consistently in use. The linked machine network ensures that every player's contribution helps build the jackpot, regardless of which machine they are playing on.

### Benefits to Players:

Players benefit from Linked Machine Contributions by having more opportunities to contribute to and trigger the jackpot, no matter which machine they are playing. The shared nature of the jackpot pool creates a communal atmosphere, as players on different machines feel connected by their contributions. Additionally, players enjoy the possibility of seeing the jackpot grow rapidly due to the combined contributions from multiple machines, increasing the overall excitement of the gaming experience.

### Benefits to Casinos:

Casinos benefit from this system by leveraging a large network of machines to fund a single, rapidly growing jackpot. The Linked Machine Contributions method encourages players to stay at the machines longer, knowing that their bets are contributing to a shared jackpot. This technique also maximizes the use of the casino's existing infrastructure, as every machine in the network helps drive contributions to the jackpot. The rapid growth of the jackpot pool creates excitement across the casino, attracting more players to the linked machines.

### Example Walk-Through Scenario:

At a major Macau casino, dozens of slot machines are linked through the Linked Machine Contributions system, all contributing to the same Mystery Jackpot pool. Mr. Yuen sits down at a machine and places a $20 bet, with 2% of his wager contributing to the shared jackpot pool. Meanwhile, Ms. Wong, playing on a different machine, places a $50 bet, and 2% of her wager is also directed to the same jackpot.

As players across the network of machines continue placing bets, the jackpot grows rapidly. The shared nature of the jackpot creates a sense of communal excitement, as players on all linked machines watch the prize pool increase in real-time. By the end of the evening, the jackpot has reached a significant amount, driving more players to the linked machines in hopes of triggering the big win.

### Example System Procedural Flow:

1. Player Bet Placement:
   Players place their wagers on linked slot machines or ETGTs, with the system tracking the amount of each bet.
2. Contribution Calculation:
   A percentage of each wager (e.g., 2%) is automatically deducted and added to the shared Mystery Jackpot pool.
3. Data Transmission to Casino Server:
   Contribution data from all linked machines is transmitted to the central casino server, where the jackpot pool is updated in real-time and displayed across all machines.
4. Ongoing Contributions:
   As players across the network of machines continue to place bets, the jackpot pool grows steadily.
5. Jackpot Trigger and Payout:
   When the jackpot is triggered, the system verifies the winning machine and awards the prize to the player, resetting the pool for continued contributions.

### Noteworthy Aspects and Features:

The Linked Machine Contributions technique offers a highly effective way to build large, shared jackpots across multiple machines. This system ensures rapid jackpot growth by pooling contributions from a wide network of machines, creating excitement and anticipation across the casino. For players, the shared nature of the jackpot adds a communal element to the gaming experience, while still allowing each individual player the chance to trigger the big win. For casinos, the linked machine network maximizes the use of existing infrastructure and drives higher betting volumes, making it an attractive option for enhancing player engagement and revenue.

### Mystery Jackpot Funding Technique #37—Random Contribution Boosts

### Description and Implementation:

The Random Contribution Boosts technique introduces unexpected and unpredictable increases in the percentage of player bets that are allocated to the Mystery Jackpot pool. At random intervals, the system temporarily increases the contribution percentage (e.g., from 1% to 5%) for a short period, encouraging players to place more bets during this “boosted” time to help grow the jackpot faster. The boost may be triggered automatically by the casino system and may apply to all bets placed during the boost period or only to specific games.

This method adds an element of surprise and excitement to the game, as players are unaware of when the next boost will occur. It may be implemented across various Live Dealer Game Tables (LDGTs) and Electronic Table Game Terminals (ETGTs), ensuring that all players in the casino may benefit from the boosted contributions.

### Benefits to Players:

Players benefit from Random Contribution Boosts by having the chance to significantly increase their contributions to the jackpot pool without needing to change their usual betting behavior. The random nature of the boost adds excitement to the game, as players are eager to participate when the contribution boost is active. This unpredictability creates a sense of urgency, motivating players to place more bets when the boost is triggered. Additionally, players feel more connected to the growth of the jackpot, as they know that their contributions during boosted periods have a larger impact.

### Benefits to Casinos:

Casinos benefit from this technique by encouraging more frequent and higher betting volumes, particularly when players are motivated to capitalize on the boost periods. Random Contribution Boosts increase overall player engagement and excitement, driving longer gaming sessions and higher revenue. The boost periods also allow casinos to strategically manage the growth of the jackpot, ensuring that it reaches significant amounts quickly. This method may be easily integrated into promotional events, further enhancing player participation and loyalty.

### Example Walk-Through Scenario:

At a busy Macau casino, players at various LDGTs and ETGTs are placing their usual wagers when the system triggers a Random Contribution Boost. The boost increases the contribution percentage from 1% to 5% for the next 15 minutes. Mr. Leung, playing roulette, places a $100 bet during the boost period, contributing $5 to the Mystery Jackpot pool instead of the usual $1. Similarly, Ms. Ng, playing blackjack, contributes $10 from her $200 bet.

As more players notice the boost period, they rush to place bets, knowing that their contributions are having a larger impact on the jackpot. The casino monitors display the growing jackpot in real-time, creating excitement throughout the casino. When the boost period ends, the jackpot has grown significantly, leaving players eager for the next boost to occur.

### Example System Procedural Flow:

1. Player Bet Placement:
   Players place their bets at LDGTs and ETGTs as usual, with the system tracking all wagers.
2. Random Boost Trigger:
   At random intervals, the system activates a temporary increase in the contribution percentage (e.g., from 1% to 5%) for a limited time.
3. Boosted Contribution Allocation:
   During the boost period, the system calculates the increased contribution from each player's bet and allocates it to the Mystery Jackpot pool.
4. Casino Server Update:
   The system transmits the boosted contributions to the central casino server, where the jackpot pool is updated in real-time and displayed to players.
5. Jackpot Growth:
   As players place more bets during the boost period, the jackpot grows rapidly, creating excitement and anticipation.
6. End of Boost Period:
   When the boost period ends, the system returns the contribution percentage to its normal level, and the jackpot pool continues to grow through regular contributions.

### Noteworthy Aspects and Features:

The Random Contribution Boosts technique adds an unpredictable and exciting element to the game, driving player engagement and increased betting during the boost periods. This system encourages players to place more bets in order to maximize their contributions to the jackpot, creating a sense of urgency and excitement. For casinos, this method offers a powerful tool for managing jackpot growth and driving player participation, particularly when integrated into promotions or special events. The random nature of the boosts keeps players on their toes, ensuring that they remain engaged throughout their gaming session.

### Mystery Jackpot Funding Technique #38—Charity Partner Contributions

### Description and Implementation:

The Charity Partner Contributions technique involves partnering with a charitable organization, where a portion of every player's bet or a percentage of the casino's earnings is allocated to both the Mystery Jackpot pool and a designated charity. For instance, 2% of every qualifying bet may go toward the jackpot pool, while an additional 1% is donated to a partnered charity. This technique integrates social responsibility with gaming, offering players the opportunity to contribute to a good cause while also funding the jackpot.

This system may be implemented across various casino games, including Live Dealer Game Tables (LDGTs) and Electronic Table Game Terminals (ETGTs). The charitable contributions are prominently displayed, ensuring that players are aware of their positive impact on both the jackpot and the charitable organization.

### Benefits to Players:

Players benefit from Charity Partner Contributions by having the opportunity to support a charitable cause while participating in the excitement of the Mystery Jackpot. Knowing that a portion of their bets is going to a worthy cause adds a feel-good element to the gaming experience, making it more rewarding. Players also feel more connected to both the casino and the charity, as they see their contributions making a difference beyond the game. The combination of social responsibility and gaming increases player loyalty and satisfaction.

### Benefits to Casinos:

Casinos benefit from this technique by enhancing their brand image and demonstrating a commitment to corporate social responsibility. The Charity Partner Contributions method helps attract socially conscious players who appreciate the chance to contribute to a good cause while gaming. This system also allows casinos to create special promotions or events centered around charitable contributions, driving increased player participation and engagement. Additionally, the partnership with a charity may generate positive publicity for the casino, attracting new patrons who are interested in supporting charitable initiatives.

### Example Walk-Through Scenario:

At a luxury casino in Macau, the management partners with a local children's charity as part of their Charity Partner Contributions initiative. During a special weekend promotion, 3% of every wager placed at participating baccarat, blackjack, and roulette tables is split between the Mystery Jackpot pool and the charity-2% going to the jackpot and 1% to the charity. Mr. Wong, placing a $100 bet on baccarat, knows that $2 from his wager is contributing to the jackpot, and $1 is being donated to the charity.

As more players participate in the promotion, both the jackpot and the charity contributions grow. The casino's monitors display the current jackpot total as well as the total amount donated to the charity, creating a sense of communal involvement and excitement. By the end of the weekend, players feel proud to have contributed to both the jackpot and a worthy cause, and the casino enjoys positive press coverage for its charitable efforts.

### Example System Procedural Flow:

1. Player Bet Placement:
   Players place their bets at participating LDGTs and ETGTs, with the system tracking each qualifying wager.
2. Contribution Split:
   A portion of each bet (e.g., 3%) is split between the Mystery Jackpot pool and the charity, with the system automatically allocating the funds.
3. Casino Server Update:
   The system transmits the contribution data to the casino's central server, updating both the jackpot pool and the charity donation totals in real-time.
4. Real-Time Display:
   The jackpot total and the amount donated to the charity are prominently displayed on casino monitors, encouraging further participation.
5. Ongoing Contributions:
   As players continue placing bets, the jackpot and charity contributions grow, creating excitement and a sense of social responsibility.
6. Jackpot Trigger and Payout:
   When the jackpot is triggered, the system verifies eligibility and awards the prize, while continuing to track ongoing charity contributions.

### Noteworthy Aspects and Features:

The Charity Partner Contributions technique uniquely blends social responsibility with gaming, allowing players to feel good about their participation while contributing to the Mystery Jackpot. This system enhances the overall player experience by adding a charitable element to the game, increasing player loyalty and satisfaction. For casinos, the partnership with a charity not only generates positive publicity but also helps attract a broader range of socially conscious patrons. The ability to drive both jackpot growth and charitable contributions makes this technique a powerful tool for boosting engagement and enhancing the casino's reputation.

### Mystery Jackpot Funding Technique #39—Jackpot Time Decay Contributions

### Description and Implementation:

The Jackpot Time Decay Contributions technique introduces a mechanism where, over time, an increasing percentage of all player bets is allocated to the Mystery Jackpot pool. As the jackpot remains unclaimed for a longer period, the contribution percentage gradually increases, accelerating the growth of the jackpot. For instance, during the first week, 1% of each bet contributes to the jackpot, but by the second week, the contribution increases to 2%, and so on, until the jackpot is won.

This technique may be implemented across various Live Dealer Game Tables (LDGTs) and Electronic Table Game Terminals (ETGTs). The gradual increase in contributions builds excitement as the jackpot grows more rapidly the longer it remains unclaimed, encouraging players to participate more as the jackpot becomes larger.

### Benefits to Players:

Players benefit from Jackpot Time Decay Contributions by experiencing a growing sense of anticipation as the jackpot increases more quickly over time. The longer the jackpot remains unclaimed, the larger the contributions become, motivating players to continue participating in hopes of triggering the big win. The time-based nature of the contributions also adds an extra layer of excitement, as players know that their contributions will have a more significant impact as the jackpot matures.

### Benefits to Casinos:

Casinos benefit from this system by driving increased player engagement over time, particularly as the jackpot reaches higher levels. The Jackpot Time Decay Contributions technique ensures that the jackpot pool grows steadily, with contributions accelerating as the jackpot remains unclaimed. This method creates a sense of urgency and excitement among players, leading to longer gaming sessions and higher betting volumes. Additionally, the gradual increase in contributions allows casinos to manage the jackpot's growth effectively while keeping players engaged.

### Example Walk-Through Scenario:

At a major Macau casino, the Mystery Jackpot has been building for two weeks without being won. Under the Jackpot Time Decay Contributions system, the contribution percentage has increased from 1% in the first week to 3% in the second week. Mr. Chen, placing a $200 bet on a blackjack game, knows that $6 of his wager is now contributing to the jackpot, compared to $2 during the first week.

As players across the casino continue to place bets, they are excited to see the jackpot grow more rapidly due to the increased contribution rate. The casino's monitors display the escalating jackpot total, encouraging more participation. By the third week, the contribution percentage increases again, driving even more excitement and anticipation as players eagerly await the chance to trigger the large, rapidly growing jackpot.

### Example System Procedural Flow:

1. Player Bet Placement:
   Players place their bets at LDGTs and ETGTs, with the system tracking the duration of time since the jackpot was last won.
2. Time-Based Contribution Increase:
   As the jackpot remains unclaimed over time, the system gradually increases the percentage of each bet that contributes to the jackpot pool.
3. Contribution Allocation:
   The system automatically allocates the increased contribution to the jackpot pool, ensuring steady and accelerated growth as time progresses.
4. Casino Server Update:
   The contribution data is transmitted to the central casino server, updating the jackpot pool in real-time and displaying the increased total to players.
5. Ongoing Contributions:
   As more time passes without the jackpot being won, the contribution percentage continues to increase, driving excitement and engagement.
6. Jackpot Trigger and Payout:
   When the jackpot is triggered, the system verifies eligibility and awards the prize, resetting the pool and restarting the time decay contribution process.

### Noteworthy Aspects and Features:

The Jackpot Time Decay Contributions technique introduces a dynamic element to the jackpot's growth, ensuring that the longer the prize remains unclaimed, the faster it grows. This system drives player engagement by creating a sense of urgency and anticipation, particularly as the contribution percentage increases over time. For casinos, this method ensures steady and accelerated jackpot growth while maintaining player interest over extended periods. The time-based nature of the contributions adds excitement to the game, encouraging players to continue participating as the jackpot matures.

### Mystery Jackpot Funding Technique #40—Promotional Jackpot Multipliers

### Description and Implementation:

The Promotional Jackpot Multipliers technique involves temporarily increasing the contribution percentage or the odds of triggering the jackpot during specific promotional events. For instance, during a weekend promotion, the casino may offer a 2× multiplier on all contributions to the Mystery Jackpot pool, or the odds of winning the jackpot may be increased for a limited time. This technique is used to create excitement and drive player participation during special events, ensuring rapid jackpot growth.

The multiplier may apply to all player wagers or be limited to specific games, such as blackjack, roulette, or baccarat. The system may be programmed to automatically apply the multiplier during the promotion, making it easy for casinos to manage and for players to participate.

### Benefits to Players:

Players benefit from Promotional Jackpot Multipliers by having the opportunity to contribute more to the jackpot or increase their chances of winning during special promotions. The limited-time nature of the promotion creates excitement and urgency, motivating players to participate more actively during the promotional period. The potential for higher contributions or improved odds adds an extra layer of excitement to the game, making the overall gaming experience more engaging and rewarding.

### Benefits to Casinos:

Casinos benefit from this system by driving increased player traffic and engagement during promotional events. The Promotional Jackpot Multipliers technique ensures that players are more motivated to participate, leading to higher betting volumes and rapid jackpot growth. This method also allows casinos to strategically plan promotions that align with their marketing goals, using the multiplier to attract players during slower periods or special events. The increased participation and excitement generated by the multiplier help boost overall revenue and player retention.

### Example Walk-Through Scenario:

At a high-end Macau casino, the management announces a weekend promotion where all contributions to the Mystery Jackpot pool will be multiplied by 2×. Mr. Lau, playing roulette, places a $100 bet, and instead of the usual 2% contribution to the jackpot, the promotion applies a 2× multiplier, contributing $4 instead of $2. Similarly, Ms. Tsang, playing baccarat, sees her $300 bet contribute $12 to the jackpot instead of the usual $6.

As more players participate in the promotional event, they are excited by the rapid growth of the jackpot, driven by the increased contributions from the multiplier. The casino's monitors display the current jackpot total, showing how quickly it is growing thanks to the promotion. By the end of the weekend, the jackpot has reached a new high, creating excitement among players eager for their chance to win.

### Example System Procedural Flow:

1. Promotion Announcement:
   The casino announces the promotional event, informing players that a multiplier (e.g., 2×) will apply to all contributions or jackpot odds during the specified period.
2. Player Bet Placement:
   Players place their bets as usual at LDGTs and ETGTs, with the system tracking all qualifying wagers during the promotional period.
3. Multiplier Application:
   The system automatically applies the promotional multiplier to each qualifying bet, increasing the contribution to the Mystery Jackpot pool or improving the odds of triggering the jackpot.
4. Casino Server Update:
   The contribution data, with the applied multiplier, is transmitted to the central casino server, where the jackpot pool is updated in real-time and displayed to players.
5. Jackpot Growth:
   As more players participate in the promotion, the jackpot grows rapidly, creating excitement and increased participation across the casino.
6. Jackpot Trigger and Payout:
   When the jackpot is triggered, the system verifies eligibility and awards the prize. The promotion ends, and the system reverts to normal contribution levels.

### Noteworthy Aspects and Features:

The Promotional Jackpot Multipliers technique provides a powerful tool for casinos to drive player participation and excitement during special events. The temporary nature of the multiplier creates a sense of urgency, encouraging players to place more bets and contribute more to the jackpot. For casinos, this method ensures rapid jackpot growth during promotions, helping to boost player traffic and revenue. The ability to easily integrate multipliers into existing systems makes this technique a flexible and effective way to enhance player engagement and jackpot growth.

### Mystery Jackpot Funding Technique #41—High Bet Jackpot Entry

### Description and Implementation:

The High Bet Jackpot Entry technique ties Mystery Jackpot eligibility to players placing high-value bets. Only wagers exceeding a predefined minimum amount (e.g., $500 or $1,000) are eligible to participate in the Mystery Jackpot pool. This method caters to high-rollers and incentivizes larger wagers, ensuring that only significant contributions qualify for jackpot participation. A percentage of each high bet (e.g., 2% to 5%) is allocated directly to the jackpot pool.

This technique may be implemented at both Live Dealer Game Tables (LDGTs) and Electronic Table Game Terminals (ETGTs), where the system tracks all wagers and only allocates contributions from qualifying high bets. The system automatically identifies high-value bets and allocates a portion to the jackpot, allowing casinos to build larger pools more quickly.

### Benefits to Players:

Players benefit from the High Bet Jackpot Entry system by gaining access to an exclusive jackpot pool reserved for high-stakes bets. The limited access to the jackpot makes the prize more attractive to high-rollers, who appreciate the challenge of competing for a significant jackpot among a smaller group of participants. Additionally, high-stakes players feel more rewarded for placing larger bets, knowing their contributions are directly impacting the size of the jackpot pool.

### Benefits to Casinos:

Casinos benefit from this system by driving higher betting volumes, particularly from high-rollers who are incentivized to place larger wagers in order to participate in the jackpot. The High Bet Jackpot Entry technique creates an exclusive and competitive environment, drawing in VIP players and maximizing revenue. This method also ensures that the jackpot pool grows rapidly, making it an appealing feature for players and a strong promotional tool for the casino.

### Example Walk-Through Scenario:

At a luxury Macau casino, Mr. Lee, a high-stakes baccarat player, places a $1,000 bet, qualifying for the High Bet Jackpot Entry system. Under this system, 5% of his wager ($50) is automatically directed into the Mystery Jackpot pool. Similarly, Ms. Zhang, placing a $2,000 bet on blackjack, contributes $100 from her wager to the jackpot.

As the night progresses, other high-rollers continue placing large bets, each contributing a percentage to the growing jackpot. The exclusivity of the system creates excitement among the players, as they know only high-value bets are building the prize pool. By the end of the evening, the jackpot has reached a significant amount, with the high-stakes players eagerly anticipating the chance to win the exclusive prize.

### Example System Procedural Flow:

1. Player Bet Placement:
   Players place bets at LDGTs or ETGTs, and the system tracks all wagers to determine which bets meet the high-value threshold.
2. Threshold Verification:
   The system verifies if the placed bet exceeds the predefined threshold (e.g., $500 or $1,000) required for jackpot contribution eligibility.
3. Contribution Calculation:
   A percentage of the qualifying high bet (e.g., 5%) is automatically allocated to the Mystery Jackpot pool.
4. Casino Server Update:
   The contribution data is transmitted to the central casino server, where the jackpot pool is updated in real-time and displayed to players.
5. Jackpot Growth:
   As more high-stakes bets are placed, the jackpot pool grows rapidly, creating excitement among participants.
6. Jackpot Trigger and Payout:
   When the jackpot is triggered, the system verifies player eligibility and awards the prize to the qualifying high-roller.

### Noteworthy Aspects and Features:

The High Bet Jackpot Entry system is designed to appeal specifically to high-stakes players, offering an exclusive opportunity to participate in a rapidly growing jackpot pool. This technique helps casinos attract VIP players and drive higher betting volumes, while also ensuring fast-paced jackpot growth. The exclusivity of the system makes it appealing to competitive high-rollers, adding an extra layer of excitement and engagement to their gaming experience.

### Mystery Jackpot Funding Technique #42—Percentage-Based Contribution Scaling

### Description and Implementation:

The Percentage-Based Contribution Scaling technique dynamically adjusts the contribution percentage based on the size of the player's bet, ensuring that larger wagers contribute more significantly to the Mystery Jackpot pool. For instance, smaller bets (e.g., $50) may contribute 1%, while medium-sized bets (e.g., $200) contribute 3%, and high-stakes bets (e.g., $1,000 or more) contribute 5% or higher. This scaling method encourages players to place larger bets to have a more significant impact on the jackpot's growth.

The system tracks all bets placed at Live Dealer Game Tables (LDGTs) and Electronic Table Game Terminals (ETGTs) and automatically adjusts the contribution percentage based on the wager size. The scaling model creates a balanced system where both casual players and high-rollers may contribute to the jackpot, but higher wagers have a greater effect on its growth.

### Benefits to Players:

Players benefit from Percentage-Based Contribution Scaling by having their contributions to the jackpot increase proportionally with the size of their bet. High-rollers, in particular, appreciate the opportunity to have a more substantial impact on the jackpot, while casual players may still participate without needing to place large bets. This system adds an element of fairness to the game, ensuring that all players, regardless of their bet size, contribute to the jackpot pool.

### Benefits to Casinos:

Casinos benefit from this system by encouraging higher betting volumes, as players are incentivized to place larger wagers to maximize their contributions. The Percentage-Based Contribution Scaling technique ensures that the jackpot grows quickly, with larger bets driving more significant contributions. The dynamic scaling also provides flexibility for the casino, allowing them to fine-tune contribution percentages to optimize player engagement and profitability.

### Example Walk-Through Scenario:

At a bustling casino in Macau, players across multiple game types are participating in the Percentage-Based Contribution Scaling system. Mr. Chan, placing a $50 bet on roulette, contributes 1% of his wager ($0.50) to the jackpot, while Ms. Wu, placing a $500 bet on baccarat, contributes 5% of her wager ($25) to the same jackpot pool.

As the night continues, both casual players and high-rollers contribute to the growing jackpot. Players are excited by the fairness of the system, knowing that their contributions scale based on their wager size. The jackpot pool grows rapidly as larger bets are placed, creating excitement across the casino floor. By the end of the evening, the jackpot has reached a significant amount, driven by the scaled contributions from players of all levels.

### Example System Procedural Flow:

1. Player Bet Placement:
   Players place their bets at LDGTs and ETGTs, and the system tracks each bet's size to determine the appropriate contribution percentage.
2. Contribution Scaling Calculation:
   The system dynamically adjusts the contribution percentage based on the wager size, ensuring that larger bets contribute a higher percentage to the jackpot pool.
3. Contribution Allocation:
   The calculated contribution is automatically allocated to the Mystery Jackpot pool, with larger bets driving more significant contributions.
4. Casino Server Update:
   The contribution data is transmitted to the central casino server, where the jackpot pool is updated in real-time and displayed to players.
5. Jackpot Growth:
   As both small and large bets are placed, the jackpot pool grows steadily, with high-stakes bets having a greater impact on its growth.
6. Jackpot Trigger and Payout:
   When the jackpot is triggered, the system verifies eligibility and awards the prize to the winning player.

### Noteworthy Aspects and Features:

The Percentage-Based Contribution Scaling system ensures that all players may participate in building the Mystery Jackpot, with larger bets contributing more significantly. This technique encourages higher betting volumes while maintaining fairness for casual players. For casinos, the dynamic scaling model drives rapid jackpot growth and provides flexibility to optimize contribution percentages, making it an effective tool for maximizing player engagement and profitability.

### Mystery Jackpot Funding Technique #43—Jackpot Linked to Slot Machine Rounds

### Description and Implementation:

The Jackpot Linked to Slot Machine Rounds technique ties the Mystery Jackpot contributions directly to slot machine rounds, where a percentage of each wager placed on the machine contributes to the jackpot pool. Each time a player spins the reels, a small portion of their bet (e.g., 1% to 2%) is allocated to the shared jackpot, allowing slot machine players to contribute steadily over time.

This system connects multiple slot machines to a single jackpot pool, ensuring that the jackpot grows quickly as more players spin the reels. The system may be implemented across a network of Electronic Gaming Machines (EGMs), with the jackpot contributions seamlessly integrated into the standard gameplay experience.

### Benefits to Players:

Players benefit from Jackpot Linked to Slot Machine Rounds by having a continuous opportunity to contribute to the Mystery Jackpot with every spin of the reels. This system provides slot machine players with a consistent and automatic way to participate in the jackpot without needing to change their betting strategy. The knowledge that each spin contributes to a growing jackpot adds excitement to the game, encouraging players to continue playing in hopes of triggering the big win.

### Benefits to Casinos:

Casinos benefit from this system by ensuring steady and consistent contributions to the jackpot pool from slot machine players. The Jackpot Linked to Slot Machine Rounds technique maximizes the use of existing slot machine infrastructure, driving higher betting volumes and increased player engagement. The system also encourages longer play sessions, as players are motivated to keep spinning the reels to build the jackpot. The continuous contributions from multiple machines ensure rapid jackpot growth, making it an attractive feature for the casino.

### Example Walk-Through Scenario:

At a large Macau casino, dozens of slot machines are linked through the Jackpot Linked to Slot Machine Rounds system. Ms. Ho, sitting at a popular slot machine, places a $10 bet and spins the reels. Under this system, 2% of her bet ($0.20) is automatically directed into the Mystery Jackpot pool. Meanwhile, other players across the casino are contributing similar percentages from their slot machine bets.

As the day progresses, the jackpot pool grows steadily from the continuous contributions of slot machine players. The casino's monitors display the current jackpot total, showing how quickly it is increasing as more players participate. By the end of the evening, the jackpot has reached a substantial amount, fueled by the collective contributions from the network of slot machines.

### Example System Procedural Flow:

1. Player Bet Placement:
   Players place their wagers on slot machines, and the system tracks each spin to calculate the appropriate contribution percentage.
2. Contribution Allocation:
   A percentage of each wager (e.g., 1% to 2%) is automatically allocated to the Mystery Jackpot pool with every spin.
3. Data Transmission to Casino Server:
   The contribution data from all linked slot machines is transmitted to the central casino server, where the jackpot pool is updated in real-time and displayed to players.
4. Jackpot Growth:
   As more players spin the reels, the jackpot pool grows steadily, creating excitement among players.
5. Continuous Play and Contributions:
   Players continue spinning the reels, knowing that each spin contributes to the growing jackpot, encouraging longer play sessions.
6. Jackpot Trigger and Payout:
   When the jackpot is triggered, the system verifies eligibility and awards the prize to the winning player.

### Noteworthy Aspects and Features:

The Jackpot Linked to Slot Machine Rounds technique offers a seamless way for slot machine players to contribute to the Mystery Jackpot with every spin. This system ensures continuous and steady contributions to the jackpot pool, driving rapid growth as more players participate. For casinos, the technique maximizes the use of existing slot machine infrastructure and encourages longer play sessions, leading to higher revenue and player engagement. The simplicity and automatic nature of the contributions make it an attractive option for both players and casinos alike.

### Mystery Jackpot Funding Technique #44—Side Bet Contribution Incentives

### Description and Implementation:

The Side Bet Contribution Incentives technique incentivizes players to place side bets by offering additional rewards for contributing to the Mystery Jackpot pool. A percentage of each side bet (e.g., 3% to 5%) is allocated to the jackpot, and players who place side bets are given enhanced odds of winning or other in-game bonuses, such as multipliers or free spins, as a reward for contributing. This system encourages players to place more side bets, knowing that they are not only building the jackpot but also increasing their chances of winning additional rewards.

This technique may be applied across a variety of games, including blackjack, baccarat, and poker, where side bets are common. The system tracks all side bets and automatically allocates the appropriate percentage to the jackpot pool, rewarding players for their contributions.

### Benefits to Players:

Players benefit from Side Bet Contribution Incentives by receiving enhanced rewards for contributing to the jackpot through side bets. The additional incentives, such as improved odds or in-game bonuses, make side betting more attractive, encouraging players to place more side bets. Players appreciate the opportunity to boost their gameplay while simultaneously contributing to the jackpot, creating a more dynamic and engaging gaming experience.

### Benefits to Casinos:

Casinos benefit from this system by driving higher side betting volumes, which in turn fuel the growth of the Mystery Jackpot pool. The Side Bet Contribution Incentives technique encourages players to place side bets more frequently, leading to higher overall betting activity and increased revenue. The system also adds an extra layer of excitement to the game, as players are motivated to contribute to the jackpot in exchange for enhanced rewards. The increased engagement and betting activity help drive longer play sessions and player retention.

### Example Walk-Through Scenario:

At a blackjack table in a Macau casino, players are offered the option to place side bets with the Side Bet Contribution Incentives system. Mr. Chen places a $20 side bet, knowing that 5% of his bet ($1) will be directed to the Mystery Jackpot pool. In exchange for contributing, he receives enhanced odds for his next hand, increasing his chances of winning a larger payout.

Throughout the game, other players also place side bets, contributing to the jackpot and receiving in-game bonuses or improved odds as a reward. The excitement around the side bets grows as players realize they are not only building the jackpot but also enhancing their gameplay experience. By the end of the session, the jackpot has grown significantly, and players are eager to continue placing side bets for both the chance to win the jackpot and the additional rewards.

### Example System Procedural Flow:

1. Side Bet Placement:
   Players place side bets at LDGTs or ETGTs, and the system tracks each side wager.
2. Contribution Allocation:
   A percentage of each side bet (e.g., 5%) is automatically allocated to the Mystery Jackpot pool, contributing to its growth.
3. Player Reward Calculation:
   The system calculates additional rewards for players who place side bets, such as improved odds, multipliers, or in-game bonuses.
4. Data Transmission to Casino Server:
   The contribution data from side bets is transmitted to the central casino server, where the jackpot pool is updated in real-time.
5. Jackpot Growth:
   As more side bets are placed, the jackpot pool grows steadily, while players enjoy enhanced rewards for their contributions.
6. Jackpot Trigger and Payout:
   When the jackpot is triggered, the system verifies eligibility and awards the prize to the winning player.

### Noteworthy Aspects and Features:

The Side Bet Contribution Incentives technique drives increased side betting activity by offering additional rewards to players who contribute to the Mystery Jackpot pool. This system encourages higher betting volumes and greater player engagement, as players are motivated by the potential for enhanced rewards. For casinos, the technique ensures steady jackpot growth while maximizing revenue from side bets, making it an effective tool for increasing both player participation and profitability. The added incentives create a more exciting and rewarding gaming experience, appealing to players who enjoy both the thrill of side bets and the potential for jackpot wins.

Mystery Jackpot Funding Technique #45—Jackpot Contribution from Unclaimed Winnings

### Description and Implementation:

The Jackpot Contribution from Unclaimed Winnings technique redirects unclaimed player winnings into the Mystery Jackpot pool after a predefined period of inactivity. If a player fails to collect their winnings within a certain time frame (e.g., 30 days for a large jackpot win, or 24 hours for smaller table game winnings), the casino allocates these unclaimed funds to the Mystery Jackpot pool. This method ensures that unclaimed prizes, which may otherwise remain unused, help to grow the jackpot, keeping the funds within the casino's gaming ecosystem.

This system may be applied to a wide variety of game types, from table games at Live Dealer Game Tables (LDGTs) to Electronic Table Game Terminals (ETGTs) and slot machines. The system monitors unclaimed winnings and automatically transfers eligible amounts to the jackpot pool once the designated period elapses.

### Benefits to Players:

Players benefit from the Jackpot Contribution from Unclaimed Winnings system by contributing to the Mystery Jackpot pool without any direct action on their part. This method appeals to players who appreciate knowing that their uncollected winnings, which may have been forgotten, are being repurposed to build the jackpot that everyone may compete for. Additionally, the system contributes to more frequent and larger jackpots, increasing the excitement of future gameplay and providing an enhanced player experience.

### Benefits to Casinos:

Casinos benefit from this system by reclaiming unclaimed winnings and putting them to use in growing the Mystery Jackpot pool. Instead of these funds remaining idle or requiring complex handling procedures, they are reinvested into a mechanism that enhances player engagement. The Jackpot Contribution from Unclaimed Winnings technique ensures that unused funds continue to drive excitement and larger jackpots, which in turn encourage higher participation rates, longer play sessions, and increased revenues.

### Example Walk-Through Scenario:

At a large Macau casino, a player wins $500 in a blackjack game but forgets to collect their winnings. After 30 days, the winnings remain unclaimed, and under the Jackpot Contribution from Unclaimed Winnings system, the funds are automatically transferred to the Mystery Jackpot pool. Similarly, at an ETGT, Ms. Lin wins a smaller amount of $20 on a poker game but neglects to collect her prize within 24 hours. This amount is also redirected to the jackpot pool.

As these unclaimed funds accumulate over time, they help grow the jackpot pool, which players may see increasing on the casino's monitors. This creates excitement among players, as the unclaimed winnings provide a steady stream of contributions to the growing jackpot. By the end of the week, the jackpot has reached a significant amount, and players are eager for the chance to win the newly expanded prize.

### Example System Procedural Flow:

1. Unclaimed Winnings Tracking:
   The system monitors player winnings at LDGTs, ETGTs, and slot machines, tracking whether winnings are claimed within a designated time frame (e.g., 24 hours for small prizes or 30 days for large wins).
2. Inactivity Detection:
   If winnings remain unclaimed beyond the set period, the system flags the funds as eligible for transfer to the Mystery Jackpot pool.
3. Automatic Transfer to Jackpot Pool:
   The system automatically transfers the unclaimed funds to the jackpot pool, updating the total in real-time.
4. Casino Server Update:
   The casino server tracks the updated jackpot amount and displays the new total on monitors across the casino.
5. Jackpot Growth:
   As more unclaimed winnings are directed into the jackpot pool, it grows steadily, creating excitement among players.
6. Jackpot Trigger and Payout:
   When the jackpot is triggered, the system verifies eligibility and awards the prize, ensuring that unclaimed winnings have contributed to a significant pool.

### Noteworthy Aspects and Features:

The Jackpot Contribution from Unclaimed Winnings technique efficiently repurposes uncollected player winnings to fuel the growth of the Mystery Jackpot. This system ensures that idle funds are reinvested into the gaming ecosystem, increasing the size of the jackpot and providing players with more frequent and larger prize opportunities. For casinos, this method reduces the complexity of handling unclaimed winnings while simultaneously driving higher player engagement and excitement around the jackpot. It offers a win-win solution that keeps the funds within the casino and contributes to ongoing player participation.

Mystery Jackpot Funding Technique #46—Contribution from Player VIP Tiers

### Description and Implementation:

The Contribution from Player VIP Tiers technique allocates a portion of high-tier VIP players' wagers toward the Mystery Jackpot pool, with higher percentages tied to more exclusive tiers. For example, Platinum-tier players may contribute 5% of each bet, while Gold-tier players contribute 3%, and Silver-tier players contribute 2%. This system ties jackpot contributions to the casino's loyalty or rewards program, incentivizing players to reach higher VIP levels for enhanced participation in the jackpot system.

This technique may be implemented across various Live Dealer Game Tables (LDGTs), Electronic Table Game Terminals (ETGTs), and slot machines, where the system automatically tracks a player's VIP status and adjusts the contribution percentage accordingly. The system encourages high-tier players to place larger wagers, knowing that their VIP level gives them a greater stake in building the jackpot.

### Benefits to Players:

Players benefit from Contribution from Player VIP Tiers by receiving enhanced rewards for reaching higher VIP statuses. The system creates a sense of exclusivity, as VIP players know that their contributions are making a more significant impact on the jackpot pool. Players are motivated to achieve higher loyalty tiers, as their enhanced contributions increase both their odds of winning and their satisfaction in seeing the jackpot grow. This system adds another dimension of rewards to the casino's loyalty program, fostering long-term engagement.

### Benefits to Casinos:

Casinos benefit from this system by incentivizing players to strive for higher VIP tiers, which encourages greater loyalty and more frequent gameplay. The Contribution from Player VIP Tiers method also ensures that higher-tier players, who often place larger bets, contribute more significantly to the jackpot, leading to faster growth. This system adds a valuable promotional tool for casinos, linking their loyalty program to the Mystery Jackpot, which drives higher betting volumes and player retention across multiple games.

### Example Walk-Through Scenario:

At a high-end Macau casino, players in different VIP tiers are contributing varying percentages of their bets to the Mystery Jackpot pool under the Contribution from Player VIP Tiers system. Mr. Li, a Platinum-tier player, places a $1,000 bet on baccarat, with 5% of his wager ($50) directed to the jackpot. Meanwhile, Ms. Wong, a Gold-tier player, places a $500 bet on roulette, contributing 3% of her wager ($15) to the same jackpot pool.

As the night progresses, the contributions from high-tier VIP players steadily grow the jackpot, creating excitement among both the high-rollers and other participants. The exclusivity of the system motivates other players to aim for higher VIP statuses, knowing that their contributions will have a larger impact on the jackpot pool once they reach the next tier.

### Example System Procedural Flow:

1. Player Bet Placement:
   Players place bets at LDGTs, ETGTs, and slot machines, and the system automatically identifies their VIP tier level.
2. Tier-Based Contribution Calculation:
   The system calculates the appropriate contribution percentage based on the player's VIP tier (e.g., 5% for Platinum, 3% for Gold, etc.) and allocates a portion of their wager to the Mystery Jackpot pool.
3. Contribution Allocation:
   The system automatically directs the calculated contribution to the jackpot pool, ensuring that higher-tier players make more significant contributions.
4. Casino Server Update:
   The contribution data is transmitted to the casino server, where the jackpot pool is updated in real-time and displayed to players.
5. Jackpot Growth:
   As VIP players place more wagers, the jackpot grows rapidly, creating excitement and engagement across the casino.
6. Jackpot Trigger and Payout:
   When the jackpot is triggered, the system verifies player eligibility and awards the prize to the winner.

### Noteworthy Aspects and Features:

The Contribution from Player VIP Tiers technique ties the casino's loyalty program directly to the growth of the Mystery Jackpot, incentivizing players to reach higher VIP statuses. This system fosters long-term player engagement by offering enhanced rewards for loyalty, while also ensuring that high-tier players contribute more significantly to the jackpot pool. For casinos, this method provides a powerful tool to encourage higher betting volumes, increase player retention, and drive faster jackpot growth. The integration of VIP tiers into the jackpot system adds a layer of exclusivity and excitement that appeals to high-rollers and frequent players alike.

### Mystery Jackpot Funding Technique #47—Linked Progressive Jackpot Contributions

### Description and Implementation:

The Linked Progressive Jackpot Contributions technique connects multiple progressive jackpots across different games or machines, allowing a portion of each progressive jackpot's contributions to be funneled into a central Mystery Jackpot pool. For example, 1% of every contribution to individual progressive jackpots (e.g., from poker or slots) is automatically redirected into the shared Mystery Jackpot, creating a larger, overarching prize pool that grows from multiple game types.

This method is particularly effective in casinos with a wide variety of progressive jackpot games, where the contributions from each individual game may be linked to drive the growth of a unified jackpot. The system is flexible and may be implemented across Live Dealer Game Tables (LDGTs), Electronic Table Game Terminals (ETGTs), and slot machines, where the system tracks all progressive contributions and allocates a portion to the central Mystery Jackpot pool.

### Benefits to Players:

Players benefit from Linked Progressive Jackpot Contributions by having the opportunity to participate in both individual progressive jackpots and a larger, overarching Mystery Jackpot. This system enhances the excitement of progressive jackpot games, as players know that each contribution is not only fueling the game-specific jackpot but also growing a communal prize pool that may be won by any eligible player. The linked nature of the system creates a sense of interconnectedness, making the overall gaming experience more engaging and rewarding.

### Benefits to Casinos:

Casinos benefit from this system by ensuring steady and rapid growth of the Mystery Jackpot pool, fueled by contributions from multiple progressive games. The Linked Progressive Jackpot Contributions technique creates a unified system that drives player engagement across a wide variety of games, encouraging higher betting volumes and longer play sessions. This method also allows casinos to offer a larger, more attractive jackpot, which may serve as a powerful promotional tool to draw in more players and boost overall revenues.

### Example Walk-Through Scenario:

At a busy casino in Macau, players across different games are contributing to both individual progressive jackpots and a central Mystery Jackpot through the Linked Progressive Jackpot Contributions system. Mr. Wong, playing a progressive slot machine, places a $20 bet, with 5% of his wager contributing to the slot's progressive jackpot and 1% ($0.20) being directed to the central Mystery Jackpot. Similarly, Ms. Liu, playing a progressive poker game, contributes a portion of her bet to both the poker-specific jackpot and the shared Mystery Jackpot pool.

As players across the casino continue to place bets on various progressive games, the Mystery Jackpot grows steadily, fueled by contributions from multiple sources. The casino's monitors display the rapidly increasing total of the Mystery Jackpot, creating excitement and anticipation among players. By the end of the night, the combined contributions have helped create a significant jackpot, attracting more players to the linked progressive games.

### Example System Procedural Flow:

1. Player Bet Placement:
   Players place bets on progressive jackpot games (e.g., slots, poker), and the system tracks all contributions to individual progressive jackpots.
2. Linked Contribution Calculation:
   The system calculates a portion (e.g., 1%) of each progressive jackpot contribution and automatically allocates it to the central Mystery Jackpot pool.
3. Contribution Allocation:
   The system directs the linked contributions to the Mystery Jackpot, ensuring that all progressive games contribute to the central pool.
4. Casino Server Update:
   The contribution data from all progressive games is transmitted to the central casino server, where the Mystery Jackpot pool is updated in real-time and displayed to players.
5. Jackpot Growth:
   As more players place bets on progressive jackpot games, the central Mystery Jackpot grows steadily, creating excitement across the casino floor.
6. Jackpot Trigger and Payout:
   When the Mystery Jackpot is triggered, the system verifies eligibility and awards the prize to the winning player.

### Noteworthy Aspects and Features:

The Linked Progressive Jackpot Contributions technique creates a unified and interconnected system that drives the rapid growth of a central Mystery Jackpot by pooling contributions from multiple progressive games. This method enhances player engagement by allowing them to participate in both individual and communal jackpots, increasing the excitement and reward potential of each game. For casinos, this system ensures fast-paced jackpot growth while promoting cross-game participation, leading to higher betting volumes and increased revenues. The linked nature of the system makes it an attractive and dynamic option for both players and casinos.

### Mystery Jackpot Funding Technique #48—Promotional Event-Based Contributions

### Description and Implementation:

The Promotional Event-Based Contributions technique ties Mystery Jackpot contributions to specific promotional events or time-limited campaigns within the casino. During these events, a portion of all player wagers (e.g., 5%) is allocated to the Mystery Jackpot pool. Promotional events may be themed around holidays, special occasions, or high-traffic periods, encouraging players to participate in the jackpot-building process during the promotion. The contributions may apply to all games or be limited to specific tables, machines, or tournaments.

This method is highly flexible and may be customized to fit the casino's promotional strategy, allowing for targeted jackpot growth during peak times. The system automatically tracks contributions during the promotional period and ensures that all eligible wagers contribute to the jackpot.

### Benefits to Players:

Players benefit from Promotional Event-Based Contributions by gaining access to a rapidly growing Mystery Jackpot during special promotional events. The limited-time nature of the promotion adds excitement and urgency, motivating players to place more wagers during the event. Players also enjoy the themed or celebratory atmosphere of the event, which enhances their overall gaming experience while contributing to a larger communal prize pool.

### Benefits to Casinos:

Casinos benefit from this system by driving increased player traffic and betting volumes during promotional events. The Promotional Event-Based Contributions technique allows casinos to strategically align jackpot growth with their marketing goals, using the event to attract more players and boost engagement. This method also ensures that the Mystery Jackpot grows rapidly during the promotion, creating a buzz around the event and encouraging longer play sessions. The flexibility of the system allows casinos to design promotions that maximize both player participation and jackpot contributions.

### Example Walk-Through Scenario:

At a popular Macau casino, the management announces a special weekend promotion to celebrate the Lunar New Year, where 5% of all bets placed during the event will contribute to the Mystery Jackpot pool. Mr. Zhang, playing baccarat, places a $100 bet, with $5 from his wager directed to the jackpot. Meanwhile, Ms. Li, playing a slot machine, contributes $2 from her $40 bet under the same promotional event.

As the weekend progresses, the contributions from all participating players help grow the Mystery Jackpot rapidly. The festive atmosphere, combined with the limited-time nature of the promotion, keeps players engaged and excited about the chance to win the expanding prize. By the end of the weekend, the jackpot has reached a significant amount, driven by the increased betting activity during the promotional event.

### Example System Procedural Flow:

1. Event Announcement:
   The casino announces the promotional event, informing players that a portion of all bets during the event will contribute to the Mystery Jackpot pool.
2. Player Bet Placement:
   Players place their wagers at LDGTs, ETGTs, or slot machines during the promotional period, and the system tracks all eligible bets.
3. Contribution Allocation:
   The system automatically allocates a percentage of each wager (e.g., 5%) to the Mystery Jackpot pool during the event.
4. Casino Server Update:
   The contribution data is transmitted to the central casino server, where the jackpot pool is updated in real-time and displayed to players.
5. Jackpot Growth:
   As more players participate in the promotional event, the Mystery Jackpot grows rapidly, creating excitement and engagement across the casino.
6. Jackpot Trigger and Payout:
   When the jackpot is triggered, the system verifies eligibility and awards the prize to the winning player.

### Noteworthy Aspects and Features:

The Promotional Event-Based Contributions technique allows casinos to tie the growth of the Mystery Jackpot to specific promotional events, creating a time-limited opportunity for players to contribute to and win a larger prize. This system enhances player excitement and engagement during the event, driving higher betting volumes and increasing player retention. For casinos, the method provides a flexible and powerful tool for boosting player participation and revenue during targeted promotional campaigns, while ensuring that the Mystery Jackpot grows rapidly and draws in more players.

### Mystery Jackpot Funding Technique #49—Cross-Game Wager Contributions

### Description and Implementation:

The Cross-Game Wager Contributions technique allocates a portion of player wagers from different game types-such as baccarat, blackjack, roulette, and slot machines—to a single, unified Mystery Jackpot pool. This method ensures that players across various games are contributing to the same jackpot, creating a larger pool more quickly. The contributions are automatically deducted from each wager placed at any participating game, with a consistent percentage (e.g., 2%-5%) being directed into the communal jackpot fund.

This technique may be applied at Live Dealer Game Tables (LDGTs) and Electronic Table Game Terminals (ETGTs), where the system tracks wagers across all linked games and allocates a portion to the Mystery Jackpot pool. The ability to link contributions from a variety of games creates a dynamic and inclusive system that encourages widespread player participation.

### Benefits to Players:

Players benefit from Cross-Game Wager Contributions by having more opportunities to participate in the growth of the Mystery Jackpot, regardless of their preferred game. The system allows all players—whether they favor slots, table games, or electronic terminals—to contribute to the same jackpot, providing a communal aspect to the gaming experience. This inclusiveness adds excitement, as players know that their contributions from different games are helping to build a large, shared prize pool.

### Benefits to Casinos:

Casinos benefit from this system by maximizing the use of existing games to grow the jackpot pool more quickly. The Cross-Game Wager Contributions technique increases betting activity across a wider variety of games, as players from different games are united in their pursuit of the same jackpot. This method drives higher engagement and betting volumes, particularly as players are encouraged to explore and contribute through different game types. By creating a unified system, casinos may offer larger, more attractive jackpots, which serve as a strong promotional tool to attract more players.

### Example Walk-Through Scenario:

At a popular casino in Macau, players across various game types are contributing to the same Mystery Jackpot pool through the Cross-Game Wager Contributions system. Mr. Yuen, placing a $100 bet on blackjack, automatically contributes 3% ($3) of his wager to the jackpot. Meanwhile, Ms. Chan, playing a slot machine, places a $50 bet, with 2% ($1) of her wager also directed to the same jackpot pool.

As the night progresses, players on roulette, baccarat, and other table games also contribute to the growing jackpot with each wager. The casino's monitors display the real-time growth of the jackpot, showing contributions from a variety of games. By the end of the evening, the jackpot has reached a significant total, creating excitement and anticipation among players across the entire casino floor.

### Example System Procedural Flow:

1. Player Bet Placement:
   Players place bets at LDGTs, ETGTs, and slot machines, with the system tracking all wagers across different game types.
2. Contribution Allocation:
   A percentage of each bet (e.g., 2%-5%) is automatically allocated to the Mystery Jackpot pool, regardless of the game type.
3. Casino Server Update:
   The system transmits contribution data from all games to the central casino server, where the jackpot pool is updated in real-time and displayed to players.
4. Unified Jackpot Growth:
   As more players contribute through different games, the unified Mystery Jackpot pool grows steadily, creating excitement and engagement across the casino.
5. Jackpot Trigger and Payout:
   When the jackpot is triggered, the system verifies eligibility and awards the prize to a player from any of the participating games, resetting the pool for continued contributions.

### Noteworthy Aspects and Features:

The Cross-Game Wager Contributions technique creates an inclusive and unified system that brings players from different game types together in their pursuit of a large communal jackpot. This method ensures rapid jackpot growth by pooling contributions from multiple games, enhancing player engagement and excitement across the casino floor. For casinos, this technique maximizes player participation, driving higher betting volumes and creating a more attractive promotional feature to draw in players from all types of games. The communal nature of the system adds a sense of shared excitement, appealing to a broad player base.

### Mystery Jackpot Funding Technique #50—Loss Rebate Jackpot Contributions

### Description and Implementation:

The Loss Rebate Jackpot Contributions technique allows players to contribute to the Mystery Jackpot pool by allocating a portion of their losses as a rebate. When a player loses a bet, a percentage of their loss (e.g., 5%) is returned to them in the form of a contribution to the jackpot. For example, if a player loses $100, $5 of that loss may be transferred into the jackpot pool on their behalf. This system offers players a sense of consolation for their losses, as part of their wager is reinvested in the chance to win a larger prize.

This technique may be implemented across various games, including table games and slot machines at Live Dealer Game Tables (LDGTs) and Electronic Table Game Terminals (ETGTs). The system tracks player losses and automatically allocates the appropriate percentage as a contribution to the Mystery Jackpot.

### Benefits to Players:

Players benefit from the Loss Rebate Jackpot Contributions system by receiving a form of compensation for their losses, giving them a second chance to win a prize. The opportunity to have part of their loss contribute to the growing jackpot adds a layer of excitement to the gaming experience, as players feel that their losses are not entirely in vain. This system helps keep players engaged, even when they are not winning, by offering them the potential to benefit from their contributions to the jackpot.

### Benefits to Casinos:

Casinos benefit from this technique by turning player losses into a positive experience, encouraging longer play sessions and higher retention rates. The Loss Rebate Jackpot Contributions method ensures that even when players lose, they continue to participate in building the jackpot, which in turn creates excitement for other players. This system enhances the overall gaming experience, fostering a sense of goodwill and keeping players invested in the casino's games, ultimately driving higher revenues through extended play and continued engagement.

### Example Walk-Through Scenario:

At a blackjack table in a Macau casino, Mr. Cheng places a $200 bet but loses the hand. Under the Loss Rebate Jackpot Contributions system, 5% of his loss ($10) is automatically allocated to the Mystery Jackpot pool, giving him a sense of consolation for his loss. Similarly, at a nearby slot machine, Ms. Wong loses $50, with 2% of her loss ($1) being directed to the same jackpot pool.

As players across the casino continue to experience both wins and losses, their contributions from losses steadily grow the jackpot. The casino's monitors display the rising jackpot total, creating excitement among both winners and those who contributed through losses. By the end of the evening, the jackpot has reached a substantial amount, fueled by the loss rebate contributions, providing hope and excitement for all players involved.

### Example System Procedural Flow:

1. Player Bet Placement:
   Players place bets at LDGTs and ETGTs, and the system tracks all wagers and outcomes.
2. Loss Detection and Contribution Calculation:
   When a player loses a bet, the system calculates a percentage of the loss (e.g., 5%) to be allocated to the Mystery Jackpot pool.
3. Contribution Allocation:
   The calculated rebate from the loss is automatically transferred to the jackpot pool, offering players a form of consolation for their loss.
4. Casino Server Update:
   The contribution data is transmitted to the casino server, where the jackpot pool is updated in real-time and displayed to players.
5. Jackpot Growth:
   As more players experience losses, their contributions continue to grow the jackpot, creating excitement and anticipation among all participants.
6. Jackpot Trigger and Payout:
   When the jackpot is triggered, the system verifies eligibility and awards the prize, resetting the pool for continued contributions.

### Noteworthy Aspects and Features:

The Loss Rebate Jackpot Contributions technique offers a unique way to keep players engaged, even when they experience losses. By turning losses into contributions to the Mystery Jackpot, this system provides players with a sense of consolation and hope for future wins. For casinos, the method helps drive player retention and longer play sessions, as players remain motivated by the potential to win the jackpot even after losing. This technique ensures steady jackpot growth while enhancing the overall player experience, making it a valuable tool for both casinos and players alike.

### Mystery Jackpot Funding Technique #51—Jackpot Contribution Via Non-Gaming Activities

### Description and Implementation:

The Jackpot Contribution via Non-Gaming Activities technique allows players to contribute to the Mystery Jackpot pool through non-gaming activities, such as dining at the casino's restaurants, booking hotel rooms, attending shows, or purchasing retail items. A small percentage of each transaction (e.g., 2%-5%) is automatically allocated to the jackpot pool. This technique provides a broader range of ways for players to engage with the casino's offerings while contributing to the jackpot without needing to place traditional game bets.

This system is particularly effective for large, integrated resorts where non-gaming activities account for a significant portion of the casino's revenue. By expanding the methods of contributing to the jackpot, the casino may appeal to a wider range of players and visitors, even those who may not be primarily focused on gaming.

### Benefits to Players:

Players benefit from Jackpot Contribution via Non-Gaming Activities by being able to participate in the growth of the Mystery Jackpot even when they are not playing casino games. The ability to contribute to the jackpot through dining, entertainment, or hotel stays adds an extra layer of excitement to their overall resort experience. Players who prefer non-gaming activities may still feel involved in the jackpot system, enhancing their connection to the casino and increasing their engagement with the resort's offerings.

### Benefits to Casinos:

Casinos benefit from this system by driving additional contributions to the Mystery Jackpot through non-gaming activities, which helps grow the jackpot pool more quickly. The Jackpot Contribution via Non-Gaming Activities technique encourages higher spending across all areas of the resort, from restaurants to retail, as players feel that their transactions contribute to the communal jackpot. This method also helps casinos integrate their entire resort ecosystem, increasing engagement and driving higher revenues from both gaming and non-gaming sources.

### Example Walk-Through Scenario:

At a large integrated resort in Macau, Mr. Wong and his family enjoy dinner at one of the casino's upscale restaurants. Under the Jackpot Contribution via Non-Gaming Activities system, 3% of their $200 dining bill ($6) is automatically allocated to the Mystery Jackpot pool. Meanwhile, Ms. Li, staying at the resort's hotel, books a $300 room for the weekend, with 2% ($6) of her room fee contributing to the same jackpot pool.

As more guests participate in non-gaming activities-whether dining, shopping, or attending a show—the Mystery Jackpot grows steadily. The casino's monitors display the increasing jackpot total, creating excitement among both gamers and non-gamers alike. By the end of the weekend, the jackpot has reached a significant total, driven by contributions from both gaming and non-gaming activities.

### Example System Procedural Flow:

1. Non-Gaming Transaction Initiation:
   Guests make purchases or bookings at the casino's restaurants, hotels, retail outlets, or entertainment venues, with the system tracking all transactions.
2. Contribution Calculation:
   A percentage of each non-gaming transaction (e.g., 2%-5%) is automatically calculated and allocated to the Mystery Jackpot pool.
3. Contribution Allocation:
   The system transfers the calculated contribution from each non-gaming activity to the jackpot pool, ensuring that all activities help grow the prize.
4. Casino Server Update:
   The contribution data is transmitted to the casino's central server, where the jackpot pool is updated in real-time and displayed to both gamers and non-gamers.
5. Jackpot Growth:
   As more non-gaming activities occur, the jackpot grows steadily, creating excitement across the entire resort.
6. Jackpot Trigger and Payout:
   When the jackpot is triggered, the system verifies eligibility and awards the prize to the winning player or guest.

### Noteworthy Aspects and Features:

The Jackpot Contribution via Non-Gaming Activities technique expands the traditional methods of contributing to the Mystery Jackpot by allowing non-gaming transactions to fuel the jackpot's growth. This system enhances the overall resort experience for guests, encouraging them to participate in both gaming and non-gaming activities while contributing to a communal jackpot. For casinos, this method drives higher revenues across all areas of the resort, ensuring that the jackpot grows quickly and remains an attractive feature for all visitors. By integrating gaming and non-gaming contributions, this technique creates a more holistic and engaging experience for everyone at the resort.

### Mystery Jackpot Funding Technique #52—Custom Player Contribution Options

### Description and Implementation:

The Custom Player Contribution Options technique allows players to choose how much of their wager they want to allocate to the Mystery Jackpot pool. Players are presented with several options (e.g., 2%, 5%, or 10% of their bet), giving them control over their contribution levels. This method empowers players by allowing them to tailor their participation in the jackpot system according to their personal preferences and budget.

This technique may be implemented at both Live Dealer Game Tables (LDGTs) and Electronic Table Game Terminals (ETGTs), where the system prompts players to select their desired contribution level before placing a bet. The flexibility of the system appeals to a wide range of players, from casual gainers to high-rollers, allowing them to adjust their contributions based on their comfort level.

### Benefits to Players:

Players benefit from Custom Player Contribution Options by having greater control over how much of their wager they want to contribute to the Mystery Jackpot. This system appeals to players who appreciate flexibility and customization in their gaming experience. High-rollers may choose to contribute a larger percentage to the jackpot, while more conservative players may opt for a smaller contribution. The ability to adjust contributions based on individual preferences increases player satisfaction and engagement.

### Benefits to Casinos:

Casinos benefit from this system by offering a personalized and flexible gaming experience that encourages higher participation in the Mystery Jackpot. The Custom Player Contribution Options technique appeals to a broader range of players, as it allows each player to decide their level of contribution, driving higher betting volumes across different player segments. This method also creates a more inclusive system, where players of all types feel empowered to participate in the jackpot in a way that suits their budget and preferences.

### Example Walk-Through Scenario:

At a high-end Macau casino, players at a baccarat table are prompted to select their Custom Player Contribution Options before placing their wagers. Mr. Zhao, a high-roller, opts to contribute 10% of his $1,000 bet ($100) to the Mystery Jackpot, while Ms. Chen, a more conservative player, chooses to contribute 2% of her $50 bet ($1) to the same jackpot pool.

As players across the casino continue to place bets with their chosen contribution levels, the jackpot pool grows steadily. The system's flexibility allows both high-stakes and casual players to participate in the jackpot-building process, creating excitement and engagement across all types of games. By the end of the night, the jackpot has grown significantly, driven by the customized contributions from a wide variety of players.

### Example System Procedural Flow:

1. Player Bet Placement and Contribution Selection:
   Players place bets at LDGTs or ETGTs, and the system prompts them to select their desired contribution level (e.g., 2%, 5%, or 10%) before confirming their wager.
2. Contribution Calculation:
   The system calculates the contribution based on the player's selected percentage and allocates it to the Mystery Jackpot pool.
3. Contribution Allocation:
   The system automatically transfers the calculated contribution from each player's bet to the jackpot pool, ensuring that all players contribute at their preferred level.
4. Casino Server Update:
   The contribution data is transmitted to the central casino server, where the jackpot pool is updated in real-time and displayed to players.
5. Jackpot Growth:
   As more players place bets with customized contributions, the jackpot pool grows steadily, creating excitement and engagement across the casino.
6. Jackpot Trigger and Payout:
   When the jackpot is triggered, the system verifies eligibility and awards the prize to a player who contributed based on their selected option.

### Noteworthy Aspects and Features:

The Custom Player Contribution Options technique offers a highly flexible and personalized approach to contributing to the Mystery Jackpot, allowing players to tailor their contributions based on their preferences and budget. This system increases player satisfaction by giving them control over how much they want to participate in the jackpot, creating a more engaging and inclusive gaming experience. For casinos, this method drives higher betting volumes by appealing to a wide range of player types, from casual gamers to high-stakes bettors, ensuring steady and significant jackpot growth.

### Mystery Jackpot Distribution Techniques Example Embodiments

### Mystery Jackpot Distribution Technique #1—Bet Proportional Distribution

### Description and Implementation:

The Bet Proportional Distribution technique allocates the jackpot based on the proportion of each player's wager relative to the total amount wagered by all participating players. At a live dealer game table (LDGT) or an Electronic Table Game Terminal (ETGT), the jackpot pool accumulates during gameplay through contributions from wagers placed by multiple players. Each player's contribution to the jackpot is tracked by the system, and when the jackpot is triggered, the distribution of the prize is proportional to the size of each player's bets.

This technique may be applied across various games, such as baccarat, blackjack, or roulette, where each round's wager is logged and stored by the casino's gaming network. For example, if a player consistently bets larger amounts than others, their share of the mystery jackpot will reflect that, resulting in a higher payout compared to others who wager smaller amounts. This distribution model incentivizes higher wagers, which benefits both players and casinos.

### Benefits to Players:

Players benefit from a reward system that values their level of participation. High-stakes players are rewarded more significantly than low-stakes players, offering them a larger slice of the jackpot. Additionally, players of all wagering levels remain eligible for a portion of the jackpot, ensuring that even casual players may enjoy the thrill of optionally winning a significant reward. This technique provides transparency and fairness, as payouts directly correlate to each player's betting behavior.

### Benefits to Casinos:

Casinos gain an advantage through the incentivization of larger wagers, as players aiming for a bigger share of the jackpot may be more to increase their bets. This encourages a more competitive atmosphere, leading to greater overall betting activity. Additionally, the system ensures player engagement across different wagering levels, helping maintain longer play sessions and increased game participation. The bet proportional system also simplifies payout calculations and integrates seamlessly with existing betting structures.

### Example Walk-Through Scenario:

At an Electronic Table Game Terminal (ETGT) connected to a networked live dealer system, five players are participating in a round of live baccarat. Throughout the session, each player places varying bet amounts. Player 1 bets $100 per round, Player 2 bets $50 per round, Player 3 bets $25, Player 4 bets $10, and Player 5 bets $5. Over the course of ten rounds, the system tracks each player's cumulative contribution to the jackpot pool.

The jackpot event is triggered when the player or dealer draws a specific hand combination-let's say Player 3 hits the qualifying hand that activates the jackpot. Although Player 3 triggered the jackpot, the distribution of the $10,000 mystery jackpot pool is determined by each player's proportional bet contributions.

Player 1, having wagered a total of $1,000, contributed the largest share and thus receives 50% of the jackpot, or $5,000. Player 2, with a total bet of $500, receives 25%, or $2,500. Player 3, despite triggering the jackpot, only bet $250, so they receive $1,250 (12.5% of the jackpot). Player 4 and Player 5, having bet $100 and $50 respectively, receive $500 (5%) and $250 (2.5%).

This proportional payout encourages players like Player 3, who may feel they missed out on a larger portion, to increase their betting activity in future sessions for a bigger share. It also ensures fairness as every player who contributed to the jackpot fund benefits.

### Example System Procedural Flow:

Player Identification and Bet Recording: Each player's wager is tracked by the ETGT or LDGT through integrated bet sensors, which identify and log the amount wagered per round. The system stores this data in a central gaming server connected to the casino's network.

Tracking Cumulative Bets: As the game progresses, the casino network continuously updates each player's total bet contribution to the jackpot pool. The jackpot system monitors both individual wagers and the collective pool.

Triggering the Jackpot: When a predefined jackpot trigger condition is met (such as a specific card combination in baccarat), the casino's software identifies the winning event and initiates the jackpot distribution process.

Proportional Calculation: The casino network calculates the total contributions of each player based on their cumulative wagers. This calculation is done in real-time by comparing the individual contributions against the overall total wagered across all players. The proportional percentages are then determined.

Jackpot Distribution: The system sends payout instructions to the ETGTs or LDGT, displaying each player's share of the jackpot on their respective screens. The payout is immediately credited to each player's account or issued as a physical reward if required.

Logging and Audit: All transaction data, including player identification, wager amounts, and jackpot distribution, is logged in the casino's secure database for auditing and compliance verification.

### Noteworthy Aspects and Features:

Fairness and Transparency: Players may see a direct relationship between their betting behavior and their rewards, promoting transparency in how jackpots are distributed.

Dynamic Incentivization: The technique encourages larger bets without alienating smaller wager players, as everyone still receives a proportional reward, albeit smaller.

Real-Time Processing: The casino gaming network efficiently tracks wagers and recalculates shares dynamically, allowing the system to handle large player pools without significant delay.

Novel Data Tracking: Unlike traditional systems where jackpots are random or fixed, this proportional distribution method leverages real-time player data to provide individualized payouts, which adds a novel layer of personalization to the jackpot distribution process.

Player Engagement: The system engages high-stakes players without discouraging low-stakes participants, balancing excitement across different wager levels.

This proportional jackpot distribution system, implemented in a highly interactive LDGT or ETGT setting, offers a structured, engaging experience that drives wagering behavior while maintaining fairness.

### Mystery Jackpot Distribution Technique #2—Last Bet Multiplier

### Description and Implementation:

The Last Bet Multiplier technique multiplies the last wager placed by each eligible player by a predefined multiplier to determine their share of the jackpot when the jackpot event is triggered. This method introduces an element of unpredictability, as a player's most recent bet carries extra significance in determining their payout. The multiplier may be set at a fixed rate or dynamically adjusted based on factors such as the size of the jackpot or the overall game activity.

In an ETGT environment, this distribution technique may be applied in games such as roulette, baccarat, or blackjack. When the jackpot trigger condition is met, the system reviews the last wager placed by each player and applies the multiplier to calculate their portion of the jackpot. The system keeps track of the most recent bet for each player and applies a consistent multiplier value (e.g., 2×, 5×) to those bets to determine their payout.

### Benefits to Players:

This technique allows players to maximize their potential winnings by strategically increasing their bet amounts before the jackpot is triggered. The last bet multiplier rewards players for bold wagering decisions, providing them with the opportunity to significantly increase their payout even if their earlier contributions were smaller. The method adds an exciting element to the game, as players are incentivized to make larger bets closer to the jackpot event, increasing the level of engagement and anticipation.

### Benefits to Casinos:

Casinos benefit by encouraging players to place higher wagers as the game progresses, particularly in anticipation of a jackpot trigger. This behavior increases overall betting volume, directly enhancing revenue from wagering. The unpredictability of when the jackpot will be triggered adds to the excitement and engagement, keeping players invested in the game for longer periods. This technique also simplifies the jackpot distribution process, as it only considers the last bet made rather than cumulative wagers over time.

### Example Walk-Through Scenario:

At a DETG with five players participating in a live blackjack game, each player places varying bets throughout the game. Player 1, who has been betting conservatively throughout the session, decides to place a $200 bet on the final round of play, sensing that the jackpot may soon be triggered. Player 2, who has been making modest wagers, places a $50 bet. Players 3, 4, and 5 wager $100, $75, and $25 respectively.

When the jackpot trigger condition is met (e.g., a specific hand combination), the casino system evaluates each player's most recent bet. For this distribution technique, the system applies a 3× multiplier to the last bet of each player. Player 1, with the highest final bet of $200, receives $600 from the jackpot. Player 2 receives $150, Player 3 receives $300, Player 4 receives $225, and Player 5 receives $75. The distribution is based entirely on each player's last bet, making the final moments of gameplay particularly thrilling.

This scenario highlights how even players who were betting cautiously may significantly increase their potential jackpot payout by strategically increasing their final wager. The multiplier encourages all players to remain engaged and consider making larger bets in the later stages of the game, boosting betting activity across the table.

### Example System Procedural Flow:

Bet Recording: The ETGT logs each player's last wager as it is placed, using sensors embedded in the betting terminals to capture the amount and timestamp of the wager.

Triggering the Jackpot: Once the predefined jackpot trigger condition occurs, the casino's central server identifies the event and initiates the jackpot distribution process.

Multiplying the Last Bets: The system retrieves the last recorded wager for each player and applies the predetermined multiplier (e.g., 3×) to those amounts. The jackpot pool is then divided based on the weighted contributions, with larger final bets receiving proportionally larger payouts.

Distributing the Jackpot: The calculated payouts are communicated to each player's terminal, displaying their portion of the jackpot based on their multiplied bet. Audit and Data Logging: All transaction data, including bet amounts, multipliers, and payouts, are securely logged for audit purposes in the casino's network.

### Noteworthy Aspects and Features:

Enhanced Player Strategy: Players are incentivized to time their larger bets carefully, adding a strategic layer to gameplay.

Dynamic Payouts: The last bet multiplier introduces unpredictability in payouts, making the game more exciting.

Simple Calculation: The technique is easy to implement, requiring only the retrieval of the last wager and the application of a multiplier.

Real-Time Data Processing: The system tracks bets in real-time, ensuring accuracy in determining the last bet placed by each player.

### Mystery Jackpot Distribution Technique #3—Cumulative Wager Share

### Description and Implementation:

Cumulative Wager Share distributes the jackpot based on the total amount wagered by each player across a predefined number of rounds or game sessions. This technique rewards long-term participation and consistent betting, as the system tracks each player's cumulative contributions over time. In an ETGT or LDGT setting, this method is ideal for players who stay engaged across multiple rounds, and it encourages continuous play by offering proportionally larger rewards for higher total wagers.

As players place their bets during gameplay, the system records each wager and continuously updates the total amount wagered by each player. When the jackpot is triggered, the system calculates each player's share by comparing their cumulative wager to the total amount wagered by all players.

### Benefits to Players:

Players who remain engaged for longer sessions and consistently place bets are rewarded more generously than those who participate intermittently or make smaller wagers. This system incentivizes players to remain active in the game, increasing their chances of securing a significant share of the jackpot. It also offers a sense of fairness, as the payout directly correlates to the player's overall contribution to the game.

### Benefits to Casinos:

For casinos, this technique encourages sustained player participation and boosts overall game activity, as players are motivated to keep betting in order to increase their cumulative contribution. The longer players stay engaged, the more revenue the casino generates from continuous wagers. Additionally, this method promotes loyalty, as players who understand they are being rewarded for their long-term contributions may be more to remain loyal to the game or casino.

### Example Walk-Through Scenario:

In a game of live dealer baccarat, four players have been betting over the course of an hour. Player 1, a high-stakes gambler, has wagered a total of $1,500 over several rounds. Player 2 has wagered $750, while Players 3 and 4 have wagered $500 and $250 respectively. The casino system tracks each bet and continuously updates each player's cumulative total.

When the jackpot event is triggered, the system calculates each player's share of the $8,000 jackpot pool based on their cumulative wager. Player 1, who contributed the most, receives 50% of the jackpot, or $4,000. Player 2 receives 25% ($2,000), Player 3 receives 12.5% ($1,000), and Player 4, with the smallest cumulative wager, receives 6.25% ($500).

This walk-through demonstrates how players who engage consistently and place higher cumulative bets are rewarded with a larger share of the jackpot. Players are encouraged to maintain their betting activity over time, and even those with lower contributions still receive a proportional reward.

### Example System Procedural Flow:

Wager Tracking: The ETGT or LDGT tracks each player's wagers over multiple rounds, storing cumulative totals in the central gaming server.

Cumulative Calculation: The system continuously updates each player's total contribution, ensuring that all bets placed throughout the session are accounted for.

Jackpot Trigger: Once the jackpot trigger condition is met, the system calculates each player's share based on their total cumulative wager relative to the overall wager pool.

Jackpot Distribution: The system displays the calculated jackpot shares to each player, ensuring that payouts are proportional to their contributions.

Logging and Auditing: The cumulative wager data, along with the jackpot distribution, is logged in the casino's network for auditing and compliance purposes.

### Noteworthy Aspects and Features:

Rewarding Loyalty: Players are incentivized to remain engaged and bet consistently, encouraging long-term participation.

Fair Distribution: Payouts are directly tied to each player's total contribution, promoting a sense of fairness and transparency.

Continuous Engagement: This technique helps casinos maintain player interest and increase wagering activity over time.

Real-Time Calculation: The system continuously updates wager totals, ensuring that the jackpot distribution process is seamless and accurate.

### Mystery Jackpot Distribution Technique #4—Equal Distribution Among Winners

### Description and Implementation:

The Equal Distribution Among Winners technique ensures that the jackpot is split evenly among all players who contributed to the jackpot fund or participated in the round that triggered the jackpot. This method fosters a sense of shared victory, as each eligible player receives an equal share of the jackpot regardless of their individual contributions. In an ETGT or LDGT setup, this technique may be applied to games such as poker, blackjack, or baccarat, where multiple players contribute to the same jackpot pool.

This system works by tracking which players are actively contributing to the jackpot fund through side bets or game participation. When the jackpot is triggered, the total prize pool is divided evenly among all eligible players, regardless of the size of their bets or their overall game performance.

### Benefits to Players:

Players benefit from this technique as it provides an equal chance for everyone to win a significant portion of the jackpot. It levels the playing field, ensuring that even those who place smaller bets or participate minimally are still eligible for a fair share of the prize. This approach promotes inclusivity, as it removes the advantage that high-stakes players may typically enjoy in other distribution methods.

### Benefits to Casinos:

For casinos, equal distribution encourages participation from a broader range of players, including those who may typically place smaller bets. It also fosters a more cooperative and engaging atmosphere, as players are motivated to continue participating in the hopes of sharing in a future jackpot. This method may also simplify payout processes, as the equal distribution of funds may require less complex calculations compared to proportional or tiered distribution methods.

### Example Walk-Through Scenario:

Five players are engaged in a game of live dealer blackjack at an ETGT. Each player contributes to the jackpot fund by placing side bets over the course of the game. Player 1 bets $100, Player 2 bets $50, Player 3 bets $25, Player 4 bets $10, and Player 5 bets $5. When the jackpot is triggered by a specific winning hand, the system identifies all players who have contributed to the jackpot pool.

Rather than calculating individual shares based on contributions, the system divides the $5,000 jackpot evenly among all five players. Each player receives $1,000, regardless of how much they wagered or contributed to the jackpot fund. This equal payout fosters a sense of camaraderie, as all participants in the winning round share in the victory equally.

In this scenario, even the lower-stakes players feel incentivized to participate, as they know they have an equal chance of winning a substantial payout. The method also keeps higher-stakes players engaged, as they remain eligible for significant rewards.

### Example System Procedural Flow:

Participation Tracking: The ETGT or LDGT records which players have contributed to the jackpot fund through side bets or game participation.

Identifying Eligible Players: When the jackpot is triggered, the system identifies all players who are eligible for a share of the prize based on their contributions to the jackpot fund.

Equal Distribution: The system calculates the total jackpot pool and divides it evenly among all eligible players.

Payout Process: The system credits each eligible player with an equal share of the jackpot, regardless of individual contribution amounts.

Data Logging: All payout transactions and eligibility data are logged for audit purposes in the casino's central gaming network.

### Noteworthy Aspects and Features:

Inclusivity: This method appeals to a wide range of players by ensuring equal payouts regardless of individual contributions.

Simplified Calculation: The equal distribution process is straightforward, requiring minimal calculation compared to other distribution techniques.

Encouraging Participation: Players are more to participate in jackpot contributions if they know their chances of receiving a share are equal to others.

Cooperative Atmosphere: This technique fosters a sense of community and shared victory among players.

### Mystery Jackpot Distribution Technique #5—Player-Level-Based Distribution

### Description and Implementation:

Player-Level-Based Distribution allocates a larger share of the jackpot to players who have achieved higher-tier loyalty status within the casino's player rewards system. This technique provides additional incentives for players to achieve and maintain high-level loyalty status (e.g., VIP Platinum, Gold), as their jackpot winnings are enhanced compared to lower-tier players.

In an ETGT or LDGT setting, player-level information is integrated with the casino's player tracking system, allowing the system to dynamically adjust each player's share of the jackpot based on their loyalty status. When the jackpot is triggered, the system first identifies the loyalty status of all players who are eligible for the payout. Higher-tier players receive a larger percentage of the jackpot, while lower-tier players receive smaller shares.

### Benefits to Players:

This technique provides substantial rewards for loyal players, motivating them to continue participating in the casino's games to maintain or improve their loyalty status. High-tier players feel valued and appreciated by the casino, knowing that their status comes with tangible benefits. Even lower-tier players are incentivized to engage more actively, as improving their loyalty status may lead to larger future rewards.

### Benefits to Casinos:

Casinos benefit from increased player loyalty and engagement, as players are motivated to participate in more games and maintain higher wager volumes in order to achieve higher loyalty tiers. This distribution technique also strengthens the casino's player rewards program, making it more attractive for players to continue visiting the casino and playing regularly to maintain or improve their loyalty status. Additionally, the technique creates a tiered system of rewards that encourages long-term player retention.

### Example Walk-Through Scenario:

In a live dealer baccarat game, five players are contributing to the jackpot fund. Player 1 has achieved VIP Platinum status, Player 2 is at Gold level, Player 3 is at Silver level, and Players 4 and 5 are at Bronze level. Each player has made varying contributions to the jackpot fund through side bets.

When the jackpot is triggered, the system identifies each player's loyalty status and adjusts their payout accordingly. Player 1, with VIP Platinum status, receives 50% of the $10,000 jackpot, or $5,000. Player 2 receives 30% ($3,000), Player 3 receives 10% ($1,000), and Players 4 and 5, with Bronze status, receive 5% each ($500).

This scenario demonstrates how the casino rewards high-tier players more generously, while still ensuring that lower-tier players receive a portion of the jackpot. The system encourages all players to strive for higher loyalty status to increase their potential rewards.

### Example System Procedural Flow:

Player Tracking Integration: The ETGT or LDGT accesses the casino's player tracking system to identify the loyalty status of each player.

Jackpot Trigger: When the jackpot is triggered, the system retrieves the loyalty status of each eligible player and calculates their share of the jackpot based on their status.

Tiered Distribution: The system assigns larger shares to higher-tier players and smaller shares to lower-tier players.

Payout Process: Each player's terminal displays their share of the jackpot, reflecting the tiered distribution based on loyalty status.

Data Logging and Auditing: All payout transactions, including player status and jackpot distribution, are logged for auditing purposes in the casino's central network.

### Noteworthy Aspects and Features:

Loyalty Incentives: The system encourages players to achieve and maintain higher loyalty tiers, directly rewarding them with larger jackpot payouts.

Dynamic Adjustment: The system dynamically adjusts payouts based on real-time loyalty status, ensuring that rewards are always proportional to player status.

Enhanced Retention: This method helps casinos retain loyal players, offering them exclusive benefits for their continued engagement.

Automated Processing: The integration of player tracking and jackpot distribution ensures seamless and automatic payout adjustments based on loyalty status.

### Mystery Jackpot Distribution Technique #6—Time Played Multiplier

### Description and Implementation:

The Time Played Multiplier distribution technique rewards players who have spent more time playing at an Electronic Table Game Terminal (ETGT) or Live Dealer Game Table (LDGT). The system applies a multiplier to the jackpot share of players who have accumulated more time actively participating in the game. This multiplier increases proportionally with the duration of play, meaning that players who stay at the table for extended periods receive a greater portion of the jackpot.

This technique may be integrated into various casino games, including baccarat, blackjack, and roulette. The system tracks the time each player spends actively engaged in the game, factoring in both the number of rounds played and the overall session time. When the jackpot is triggered, the system applies a time-based multiplier to determine the size of each player's jackpot payout.

### Benefits to Players:

Players benefit from a payout system that rewards sustained engagement. The more time a player spends at the table, the greater their reward potential becomes. This incentivizes players to remain in the game for longer sessions, as they know their continued participation increases their share of the jackpot. It provides a sense of progression and fairness, encouraging even casual players to stay involved and reap higher rewards over time.

### Benefits to Casinos:

Casinos benefit by encouraging longer play sessions, which increases overall game participation and betting activity. The longer players remain engaged, the more wagers they are to place, leading to higher revenues for the casino. Additionally, the time-based multiplier may be an effective retention tool, as players are motivated to continue playing to maximize their potential rewards. This technique also helps casinos balance player volume and session length, promoting consistent player engagement across various gaming periods.

### Example Walk-Through Scenario:

In a live dealer roulette game at an ETGT, five players are participating. Player 1 has been playing for 90 minutes, Player 2 for 60 minutes, Player 3 for 45 minutes, Player 4 for 30 minutes, and Player 5 just joined the game 10 minutes ago. The system continuously tracks each player's session time.

When the jackpot event is triggered, the system applies a time-based multiplier to the $8,000 jackpot pool. Player 1, having played the longest, receives a 3× multiplier on their portion of the jackpot, earning $3,000. Player 2, with a 2× multiplier, receives $2,000. Player 3, with a 1.5× multiplier, receives $1,500, and Player 4, with a 1× multiplier, receives $1,000. Player 5, who just joined, receives a smaller portion of $500, as their time played multiplier is minimal.

This walk-through demonstrates how players who invest more time in the game are rewarded with larger jackpot payouts, encouraging sustained participation and engagement.

### Example System Procedural Flow:

Time Tracking: The ETGT system records the login time of each player and tracks their continuous participation time at the table.

Calculating Multipliers: The system assigns a time-based multiplier to each player based on the total time they have spent actively playing. The longer the play session, the higher the multiplier.

Triggering the Jackpot: Once the jackpot trigger event occurs, the system calculates the time-played multiplier for each player.

Applying the Multiplier: The system multiplies each player's share of the jackpot by their respective time-based multiplier, determining the final payout amount.

Payout and Logging: Each player's final payout is displayed on their terminal, and all relevant session data (including time played and multiplier) is logged in the casino's central network for auditing and reporting.

### Noteworthy Aspects and Features:

Sustained Engagement: Players are incentivized to remain engaged for longer periods, leading to increased play time and higher wagering.

Fairness in Reward: Players who have invested more time in the game are rewarded proportionally, ensuring that all players are incentivized to stay involved.

Automated Time Tracking: The system automatically tracks playtime, making it easy to implement without requiring manual player input.

Retention and Loyalty: This technique encourages player loyalty by rewarding continued engagement, making it a valuable tool for player retention.

### Mystery Jackpot Distribution Technique #7—Skill-Based Distribution

### Description and Implementation:

The Skill-Based Distribution technique allocates larger portions of the jackpot to players who demonstrate higher in-game skill or achieve specific gameplay milestones. This method rewards players not just for their financial contributions but for their performance and strategy. In games like blackjack or poker, where player decisions significantly impact the outcome, skill-based distribution may be highly effective in creating a competitive environment.

The system tracks player actions, such as successful hands, strategic decisions, and achievement of specific milestones (e.g., consecutive wins or rare hand combinations). When the jackpot is triggered, the system reviews each player's performance and distributes the jackpot accordingly, with more skilled players receiving a larger share.

### Benefits to Players:

Players who enjoy games of skill benefit from this technique because it offers additional rewards for their mastery of the game. Those who make strategic decisions or achieve consistent success are given a higher share of the jackpot, which incentivizes them to keep honing their skills. It also adds a layer of excitement and competition, as players are encouraged to outperform their peers to earn larger payouts.

### Benefits to Casinos:

Casinos benefit from the increased competitiveness this technique fosters among players. Skill-based jackpots encourage players to stay engaged and invest more time in perfecting their strategies, which leads to longer play sessions and increased wager volume. Furthermore, it attracts skilled players who are looking for more than just luck-based payouts, thus enhancing the reputation of the casino for offering challenging and rewarding gameplay experiences.

### Example Walk-Through Scenario:

In a live dealer poker game, five players are participating, each making different strategic decisions. Player 1 consistently wins hands using advanced strategies, accumulating high-value hands multiple times. Player 2 plays conservatively but manages to win several notable rounds. Players 3, 4, and 5 play less strategically and win fewer hands.

When the jackpot is triggered, the system evaluates each player's performance. Player 1, who demonstrated the most skill by winning multiple high-value hands, receives the largest portion of the jackpot: $4,000 out of a $10,000 pool. Player 2, who also performed well but was less aggressive, receives $3,000. The remaining players, who contributed but did not exhibit high levels of skill, split the remaining $3,000 based on their performance.

This scenario shows how skill-based rewards may drive more competitive play, pushing players to improve their game in order to win larger portions of the jackpot.

### Example System Procedural Flow:

Skill Tracking: The system tracks in-game actions and outcomes, identifying notable performance metrics such as hands won, strategic plays, and milestones achieved.

Performance Evaluation: At the end of each round, the system logs player performance data and assigns a skill rating based on predefined criteria.

Jackpot Trigger: Once the jackpot is triggered, the system calculates each player's share based on their skill rating and overall performance.

Payout Distribution: The system awards larger shares of the jackpot to players with higher skill ratings, while those with lower ratings receive smaller portions.

Data Storage: The casino's network stores all performance data and payout information for audit and analysis.

### Noteworthy Aspects and Features:

Competitive Play: The technique fosters a highly competitive environment, rewarding skillful players.

Encourages Mastery: Players are motivated to refine their strategies and improve their performance.

Real-Time Skill Assessment: The system dynamically tracks and assesses skill levels, providing fair and accurate payouts.

Attracts Skilled Players: This distribution technique appeals to serious gainers, enhancing the casino's reputation for high-quality gameplay experiences.

### Mystery Jackpot Distribution Technique #8—Risk-Based Distribution

### Description and Implementation:

The Risk-Based Distribution technique rewards players who take greater risks during gameplay, such as placing high-stakes bets on less favorable outcomes. This technique is designed to incentivize players who are willing to bet on high-risk, high-reward scenarios by offering them a larger share of the jackpot when it is triggered.

In a game like roulette or baccarat, the system identifies higher-risk wagers (such as betting on a single number in roulette or the tie outcome in baccarat) and increases the jackpot share for players who made those bets. The system tracks which bets are considered riskier, and when the jackpot is activated, those players who placed riskier bets receive a proportionally larger payout.

### Benefits to Players:

Players who enjoy the thrill of high-risk betting are directly rewarded for their bold decisions. This technique gives them the chance to amplify their jackpot payout by taking calculated risks. It also adds excitement to the game, as players know that riskier bets come with the potential for significantly larger rewards. Even if a risky bet doesn't win the game round, it still contributes to a larger jackpot share.

### Benefits to Casinos:

For casinos, this technique encourages higher-risk, higher-stakes bets, which in turn increases the overall wager volume. Players are incentivized to take more daring bets, knowing that even if they lose a round, they still stand to gain a larger share of the jackpot. This results in increased betting activity, especially on bets that are traditionally less favored but carry higher odds.

### Example Walk-Through Scenario:

In a live dealer roulette game, five players are placing various bets. Player 1 consistently bets on single numbers, while Player 2 places split bets. Players 3, 4, and 5 focus on safer, outside bets like red/black or even/odd. The system classifies single-number bets and split bets as higher-risk, while outside bets are lower-risk.

When the jackpot event is triggered, the system allocates larger portions of the $6,000 jackpot to players who placed riskier bets. Player 1, who made the riskiest bets on single numbers, receives $2,500. Player 2, who placed split bets, receives $2,000. Players 3, 4, and 5, who made lower-risk bets, split the remaining $1,500 equally.

This walk-through demonstrates how players are rewarded not just for the size of their bets but for the risks they took. High-risk players receive a larger share of the jackpot, encouraging daring gameplay.

### Example System Procedural Flow:

Risk Classification: The system classifies all bets placed during gameplay according to their risk level, with high-risk bets receiving special consideration.

Tracking Bets: Each player's bets are logged and categorized based on the risk involved. The system continuously monitors these classifications throughout the session.

Jackpot Trigger: Once the jackpot is triggered, the system reviews the classified bets and calculates larger payouts for players who placed higher-risk wagers.

Payout Process: The system distributes larger portions of the jackpot to those who placed higher-risk bets, while lower-risk players receive smaller portions.

Logging and Reporting: All bet classifications and jackpot distributions are recorded in the casino's network for audit and compliance purposes.

### Noteworthy Aspects and Features:

Risk-Reward Dynamic: This technique rewards players who are willing to take on more risk, adding excitement and strategy to the game.

Encourages Bolder Bets: Players are incentivized to take higher-risk wagers, which increases overall betting activity.

Customizable Risk Levels: Casinos may define which bets qualify as high-risk, allowing for flexible integration into different games.

Increased Revenue: By encouraging higher-risk bets, casinos may drive higher revenue from more aggressive betting behavior.

### Mystery Jackpot Distribution Technique #9—Cross-Table Distribution

### Description and Implementation:

Cross-Table Distribution allows players at linked or adjacent tables to share in a portion of the jackpot based on the outcomes of synchronized game events. This technique fosters a sense of shared excitement and community among players at multiple tables, as they know their gameplay may affect, and be affected by, other tables.

The system connects multiple tables through a network, allowing jackpot-triggering events at one table to trigger payouts at others. For example, in a casino environment with multiple ETGTs or LDGTs playing baccarat or roulette, a winning hand or spin at one table may activate a jackpot payout shared across several tables.

### Benefits to Players:

Players enjoy a sense of collective participation and shared excitement, knowing that their game outcomes may influence jackpots across multiple tables. This distribution method increases the social aspect of gaming, as players across different tables become part of a larger, interconnected jackpot experience. It also offers more opportunities for players to win, as they are no longer limited to the outcomes of their own table.

### Benefits to Casinos:

Casinos benefit by increasing the scope of jackpot events, creating more frequent and larger payouts that keep players engaged. Cross-table distribution encourages players to stay at their table longer, knowing that a jackpot trigger at a different table may result in a payout for them. It also promotes table linking, which increases player traffic across multiple games and gaming areas within the casino.

### Example Walk-Through Scenario:

In a large casino with multiple ETGTs playing live dealer baccarat, three tables are linked through the casino's network. At Table 1, a player wins with a rare hand combination, triggering a $10,000 jackpot. The Cross-Table Distribution system activates, and players at Table 2 and Table 3, who have also been contributing to their respective jackpot pools, receive a share of the payout.

Players at Table 2 receive $4,000, divided equally among the contributing players, while players at Table 3 receive $3,000. The remaining $3,000 is distributed to the winning players at Table 1. This walk-through shows how interconnected gameplay across multiple tables may create a larger and more engaging jackpot experience for players.

### Example System Procedural Flow:

Table Linking: The system links multiple tables across the casino network, allowing them to share jackpot pools.

Contribution Tracking: The system tracks contributions to the jackpot fund from players at each linked table, ensuring accurate participation data.

Jackpot Trigger: When a jackpot event is triggered at one table, the system activates Cross-Table Distribution, allocating shares of the jackpot to players at linked tables.

Payout Distribution: The system calculates the payout amounts for each linked table based on contributions and allocates the jackpot accordingly.

Audit and Logging: All linked table data, contributions, and payouts are stored in the casino's central system for compliance and auditing.

### Noteworthy Aspects and Features:

Interconnected Gameplay: This technique connects multiple tables, fostering a shared gaming experience.

Increased Jackpot Opportunities: Players have more chances to win, as they are not limited to their own table's outcomes.

Social Engagement: Cross-table interaction enhances the social aspect of gaming, creating a more dynamic environment.

Scalable Network: The system may link multiple tables across large casino floors, driving more player participation and engagement.

### Mystery Jackpot Distribution Technique #10—Participation in Bonus Rounds

### Description and Implementation:

The Participation in Bonus Rounds technique distributes a portion of the jackpot to players who have actively participated in specific bonus rounds during gameplay. This method rewards players for engaging in optional or triggered bonus rounds, which are often integrated into the main game. In an Electronic Table Game Terminal (ETGT) or Live Dealer Game Table (LDGT), bonus rounds may be triggered by specific in-game events, such as winning a certain hand combination in poker or landing on a particular slot in roulette.

When the jackpot event is triggered, only players who participated in these bonus rounds are eligible for a share of the jackpot. The system tracks which players entered or contributed to the bonus rounds and allocates jackpot shares accordingly. The size of the payout for each player may depend on their performance in the bonus round, their bet size during that round, or the number of rounds they participated in.

### Benefits to Players:

This technique offers players an additional layer of excitement by providing them with opportunities to earn extra rewards through bonus gameplay. Players who take part in bonus rounds are rewarded with a higher chance of securing a jackpot share, creating an incentive for them to engage with every aspect of the game. It adds variety to the gaming experience and makes players feel rewarded for taking extra chances or engaging in side activities within the game.

### Benefits to Casinos:

Casinos benefit by encouraging increased participation in bonus rounds, which often may require additional wagers. This increases the overall betting volume and enhances player engagement. By incorporating bonus rounds into the jackpot distribution system, casinos may keep players invested in the game for longer periods, as they are incentivized to keep playing in order to participate in potential jackpot-triggering events. It also provides a way for casinos to create unique gameplay experiences that appeal to players looking for more dynamic and interactive gaming options.

### Example Walk-Through Scenario:

In a live dealer blackjack game at an ETGT, five players are participating. Throughout the game, players have the option to enter bonus rounds by placing side bets on specific outcomes, such as getting a blackjack or hitting a pair.

Player 1 consistently enters the bonus rounds, wagering additional amounts on side bets and participating in three bonus rounds over the course of the game. Players 2 and 3 participate in one bonus round each, while Players 4 and 5 opt out of the bonus rounds entirely.

When the jackpot event is triggered by a rare hand combination, the system identifies the players who participated in the bonus rounds. Player 1, having participated in the most bonus rounds, receives 60% of the $10,000 jackpot, earning $6,000. Players 2 and 3, who participated in one bonus round each, receive 20% and 15% of the jackpot, respectively. Players 4 and 5, who did not participate in any bonus rounds, are ineligible for a share of the jackpot.

This scenario highlights how participation in bonus rounds may significantly impact a player's potential jackpot earnings, encouraging more players to engage with bonus features during gameplay.

### Example System Procedural Flow:

Bonus Round Tracking: The ETGT or LDGT tracks which players opt into and participate in bonus rounds, logging their participation and wager amounts.

Triggering the Jackpot: When the jackpot event is triggered, the system identifies all players who participated in bonus rounds during the session.

Calculating Shares: The system calculates the jackpot share for each eligible player based on their participation in bonus rounds. This may include factors like the number of rounds they played or the outcomes of those rounds.

Payout Process: The system distributes the jackpot to eligible players based on their bonus round participation, with larger shares going to those who engaged more frequently.

Logging and Auditing: All participation data, wager amounts, and jackpot payouts are recorded in the casino's central system for auditing and compliance.

### Noteworthy Aspects and Features:

Enhanced Engagement: Players are motivated to participate in bonus rounds, adding depth to the gaming experience.

Increased Wager Volume: By incentivizing bonus rounds, casinos may boost overall betting activity.

Reward for Participation: Players who engage more deeply with the game are rewarded with a larger share of the jackpot, promoting continuous involvement.

Dynamic Gameplay: The integration of bonus rounds adds variety and excitement to standard game formats, appealing to players who seek more interactive experiences.

### Mystery Jackpot Distribution Technique #11—Sequential Jackpot Share

### Description and Implementation:

The Sequential Jackpot Share technique distributes the jackpot in a series of rounds, with each player receiving a progressively smaller portion as the distribution continues. This technique creates a cascading effect, where the first player to receive a payout gets the largest share, and subsequent players receive smaller and smaller portions. This method is particularly suited to multiplayer games at ETGTs and LDGTs, where several players are contributing to a single jackpot pool.

The system ranks players based on their performance, contributions, or specific game outcomes. When the jackpot is triggered, the first player in the ranking receives the largest share of the jackpot, and the system then distributes the remaining funds in sequentially smaller portions to the other players.

### Benefits to Players:

Players are incentivized to perform well during gameplay, as higher-ranking players receive larger portions of the jackpot. This technique adds an element of competition, with players vying to secure the top spot and the largest share.

Additionally, even players who don't rank highest still receive a portion of the jackpot, maintaining engagement across the player base.

### Benefits to Casinos:

Casinos benefit from increased player competition, which may drive longer play sessions and higher betting activity. The cascading jackpot distribution keeps players engaged even after the jackpot is triggered, as there is still an opportunity to win subsequent shares. This method also helps distribute jackpot funds across multiple players, spreading the excitement and satisfaction of winning, which may promote player retention and encourage return visits.

### Example Walk-Through Scenario:

In a live dealer poker game at an ETGT, five players are competing for the jackpot. Throughout the session, the system tracks each player's performance, including the number of hands won and the size of their wagers. Player 1 consistently wins the most hands and places the largest bets, followed by Player 2 with moderate success, and Players 3, 4, and 5 with varying levels of performance.

When the jackpot event is triggered, the system ranks the players based on their performance. Player 1, having performed the best, receives 40% of the $12,000 jackpot, or $4,800. Player 2 receives the next largest share of 30%, or $3,600. Players 3, 4, and 5 receive 15%, 10%, and 5% of the jackpot, respectively, with smaller portions awarded as the distribution progresses.

This walk-through demonstrates how the Sequential Jackpot Share technique rewards top-performing players while still ensuring that all participants receive a portion of the jackpot.

### Example System Procedural Flow:

Performance Tracking: The ETGT or LDGT system tracks each player's performance, including notable metrics such as hands won, wagers placed, and rounds participated in.

Ranking Players: When the jackpot is triggered, the system ranks players based on their performance metrics, determining the order of payout.

Sequential Distribution: The system distributes the jackpot sequentially, starting with the highest-ranking player who receives the largest share. Subsequent players receive progressively smaller portions.

Payout and Logging: Each player's payout is displayed on their terminal, and the transaction data is recorded in the casino's network for auditing and compliance purposes.

Final Distribution: The system continues distributing the jackpot until all players have received their respective shares, ensuring that the entire pool is allocated.

### Noteworthy Aspects and Features:

Competitive Incentive: Players are motivated to perform well, as the best-performing players receive the largest jackpot shares.

Gradual Distribution: The cascading effect of the distribution keeps players engaged, even after the initial payout is made.

Inclusive Payouts: All players receive a portion of the jackpot, ensuring that no one is left out of the reward structure.

Engagement Across the Table: The technique fosters ongoing competition and participation, driving continued player involvement throughout the game session.

### Mystery Jackpot Distribution Technique #12—Neighbor Luck Share

### Description and Implementation:

The Neighbor Luck Share technique distributes a small percentage of the jackpot to players sitting next to the player who triggers the jackpot. This method creates a social and interactive gaming environment, where players feel a sense of shared excitement and camaraderie. In an ETGT or LDGT, the system tracks the physical or virtual seating arrangements of players and automatically allocates a portion of the jackpot to adjacent players when the jackpot is triggered.

The primary winner still receives the largest portion of the jackpot, but the Neighbor Luck Share ensures that nearby players also enjoy a small reward. This technique is particularly effective in games where player seating or terminal proximity is a notable element, such as poker or blackjack.

### Benefits to Players:

Players benefit from the social aspect of this distribution technique, as they have an opportunity to win a portion of the jackpot simply by being seated next to the jackpot winner. This creates an atmosphere of shared luck, making the gaming experience more enjoyable and engaging for everyone involved. Players who may not win directly still feel included in the excitement, which may increase their satisfaction and encourage them to continue playing.

### Benefits to Casinos:

Casinos benefit from increased player interaction and engagement. The Neighbor Luck Share technique fosters a more collaborative and social gaming environment, which may enhance player retention and satisfaction. It also encourages players to remain seated at their tables for longer periods, knowing that they may win a portion of the jackpot simply by being in proximity to the winner. This technique may help create a positive atmosphere, leading to repeat visits and increased customer loyalty.

### Example Walk-Through Scenario:

In a live dealer baccarat game, Player 1 triggers the jackpot by winning with a rare hand combination. The system identifies that Players 2 and 3 are seated next to Player 1 at adjacent terminals. While Player 1 receives the largest share of the $15,000 jackpot, earning $10,000, Players 2 and 3 each receive 5% of the jackpot, or $750 each, through the Neighbor Luck Share distribution.

This walk-through shows how even players who did not directly trigger the jackpot may still benefit from being in the right place at the right time. The Neighbor Luck Share technique enhances the social aspect of gaming, ensuring that multiple players feel the excitement of a jackpot win.

### Example System Procedural Flow:

Seating Arrangement Tracking: The ETGT or LDGT system tracks the seating arrangement of players, identifying which players are seated adjacent to one another.

Jackpot Trigger: When the jackpot is triggered, the system identifies the neighboring players of the jackpot winner based on their seating positions.

Allocating Shares: The system calculates a small percentage of the jackpot to be distributed to neighboring players, while the main portion is awarded to the primary winner.

Payout Process: Each neighboring player's payout is displayed on their terminal, along with the primary winner's share, ensuring that everyone is aware of the distribution.

Audit and Data Logging: All seating data, jackpot distribution, and payouts are recorded in the casino's central system for auditing and compliance purposes.

### Noteworthy Aspects and Features:

Social Interaction: This technique promotes a social and collaborative atmosphere, where players feel connected to one another through shared winnings.

Boosts Engagement: Players are more to stay seated at their table, knowing that proximity to a jackpot winner may result in a payout for them.

Inclusive Rewards: Even players who do not directly trigger the jackpot feel included in the reward system, which enhances overall satisfaction.

Camaraderie and Excitement: The Neighbor Luck Share technique increases the level of excitement at the table, as multiple players share in the thrill of the jackpot win.

### Mystery Jackpot Distribution Technique #13—Geographical-Based Distribution

### Description and Implementation:

The Geographical-Based Distribution technique allocates a portion of the jackpot to players based on their physical location within the casino or across linked gaming areas. This method is particularly useful in large casinos or gaming networks where players are spread across different regions or sections. The system tracks the physical location of each player and ensures that when a jackpot is triggered, players from specific areas or regions receive a share of the payout.

In an ETGT setup, players seated in certain sections of the gaming floor or specific geographical zones of the casino may receive a portion of the jackpot based on their location. The system may be customized to prioritize players in certain high-traffic or premium areas, creating additional incentives for players to occupy these areas.

### Benefits to Players:

Players benefit from an additional layer of opportunity, as their physical location within the casino may influence their chance of receiving a jackpot payout. This technique provides players with more ways to win and may encourage them to explore different areas of the casino or gaming floor. It also adds an element of excitement and novelty to the game, as players realize that their location plays a role in their potential jackpot earnings.

### Benefits to Casinos:

Casinos benefit from the ability to direct player traffic to specific areas of the gaming floor, increasing occupancy in high-value or underutilized zones. Geographical-based distribution also allows casinos to create premium gaming areas where players know they have a higher chance of receiving a jackpot payout. This may lead to increased betting activity in targeted regions, optimizing the use of space and resources within the casino.

### Example Walk-Through Scenario:

In a large casino with multiple ETGTs spread across different sections, the Geographical-Based Distribution technique is implemented. Players seated in the VIP section of the casino have a higher chance of receiving a share of the jackpot, while players in the general section have a smaller chance. When the jackpot is triggered by a player in the general section, 60% of the $20,000 jackpot goes to the winner, while the remaining 40% is distributed to players in the VIP section, regardless of their individual contributions.

This scenario demonstrates how the geographical location of players may influence their jackpot share, incentivizing players to move to premium areas for a better chance at winning a portion of the jackpot.

### Example System Procedural Flow:

Location Tracking: The ETGT system tracks the physical location of each player based on their terminal's position within the casino.

Jackpot Trigger: When the jackpot event is triggered, the system identifies the location of the triggering player and any geographical regions designated for jackpot distribution.

Allocating Shares: The system calculates how much of the jackpot will be allocated to players based on their geographical location, distributing a larger share to players in designated premium areas.

Payout Process: Players receive their payouts based on their location, with the primary jackpot winner receiving the largest share and geographically favored players receiving a portion.

Audit and Reporting: All location data, jackpot distribution, and payout transactions are logged in the casino's network for compliance and analysis.

### Noteworthy Aspects and Features:

Location-Based Incentives: Players are encouraged to move to specific areas of the casino for a better chance at receiving a jackpot payout.

Dynamic Payouts: The system allows casinos to adjust payouts based on the physical location of players, providing flexibility in how rewards are distributed.

Traffic Optimization: Casinos may use this technique to direct player traffic to high-value or underutilized areas, maximizing space and resource utilization.

Unique Experience: Geographical-based distribution adds a novel and exciting element to the game, making players feel that their physical presence in certain areas enhances their chances of winning.

### Mystery Jackpot Distribution Technique #14—Random Player Selection

### Description and Implementation:

The Random Player Selection technique distributes the jackpot by randomly selecting one or more players from the pool of participants when the jackpot is triggered. The selection process is entirely based on chance, ensuring that all eligible players, regardless of their bet size or performance, have an equal opportunity to win a share of the jackpot. This technique is ideal for casinos that want to foster inclusivity and maintain an element of unpredictability in their jackpot distribution.

In an ETGT or LDGT environment, the system tracks all active players who have placed qualifying bets during gameplay. When the jackpot event occurs, the system uses a random number generator (RNG) to select one or more players to receive a portion of the jackpot. Depending on the game configuration, a single player may win the entire jackpot, or multiple players may receive smaller, randomly assigned portions.

### Benefits to Players:

This technique benefits all players by giving everyone an equal chance to win, regardless of their performance or bet size. It adds an element of surprise and excitement, as players are aware that at any moment, they may be selected for a jackpot payout. The randomness of the selection ensures that even casual or low-stakes players remain engaged, knowing they have as much of a chance as higher-stakes players to win a significant prize.

### Benefits to Casinos:

For casinos, this technique promotes fairness and excitement, helping to maintain player engagement across all levels. Because the outcome is random, it keeps players of all types participating, fostering a sense of inclusivity. The random selection process also reduces the likelihood of player frustration, as every participant knows they have an equal shot at winning. This technique is simple to implement and integrates well into existing jackpot systems, requiring minimal adjustments to the overall gameplay structure.

### Example Walk-Through Scenario:

In a live dealer baccarat game, five players are participating. All players have placed their qualifying bets, and the system is tracking their participation. When the jackpot trigger occurs, the system activates its random number generator to select one player for a $10,000 jackpot payout.

Player 3, who has been placing modest bets throughout the session, is randomly selected to receive the entire jackpot. Despite placing smaller bets than some of the other players, Player 3's luck has paid off, and they win the $10,000 prize. The other players congratulate Player 3, knowing that the random selection process gave everyone an equal opportunity to win.

This walk-through shows how the Random Player Selection technique introduces an element of chance into the jackpot distribution process, keeping all players engaged and excited.

### Example System Procedural Flow:

Player Tracking: The ETGT or LDGT system identifies and logs all players who have placed qualifying bets, ensuring they are eligible for the jackpot.

Random Selection: Once the jackpot is triggered, the system uses an RNG to randomly select one or more players from the pool of eligible participants.

Jackpot Allocation: The system determines the portion of the jackpot that will be awarded to the randomly selected player(s). If multiple players are selected, the jackpot is divided equally or proportionally.

Payout and Display: The selected player(s) receive their payout, which is displayed on their terminal, and all other players are informed of the random selection results.

Logging and Audit: All random selection data, including the RNG process and jackpot distribution, is logged for audit and compliance purposes within the casino's system.

### Noteworthy Aspects and Features:

Equal Opportunity: All players have an equal chance of winning, regardless of bet size or performance, ensuring inclusivity and fairness.

Excitement and Surprise: The randomness of the selection keeps the game thrilling, as any player may be chosen to receive the jackpot.

Simplicity: The technique is easy to implement and may require minimal adjustments to existing jackpot systems.

Increased Player Engagement: Knowing they have an equal chance of being selected, players are more to stay engaged in the game, leading to longer play sessions.

### Mystery Jackpot Distribution Technique #15—High-Risk Bet Rewards

### Description and Implementation:

The High-Risk Bet Rewards technique allocates a larger portion of the jackpot to players who consistently place high-risk bets during gameplay. This method rewards players who are willing to take bigger risks, such as betting on less probable outcomes (e.g., single numbers in roulette or specific hand combinations in blackjack). The system tracks these high-risk wagers and gives players who place them a greater share of the jackpot when it is triggered.

This distribution technique is ideal for games where bet risk is variable, allowing players to make more aggressive, riskier bets in exchange for the possibility of higher payouts. When the jackpot is triggered, the system evaluates the number and size of high-risk bets placed by each player and allocates larger shares of the jackpot to those who have made riskier wagers.

### Benefits to Players:

Players who enjoy taking big risks are rewarded with larger jackpot shares, providing them with an extra incentive to make more daring bets. This technique creates excitement and encourages players to step out of their comfort zone by placing high-risk bets that may lead to significant rewards. It also appeals to players who prefer a more dynamic and strategy-driven approach to their gameplay, as they may influence their potential jackpot payout by adjusting their bet strategy.

### Benefits to Casinos:

Casinos benefit from increased wager volume and higher betting activity, as players are incentivized to place more high-risk bets. This technique drives greater player engagement and keeps the gameplay exciting, as players are constantly weighing the potential rewards of their high-risk bets. It also allows casinos to cater to a wider range of players, including those who prefer more aggressive betting strategies.

### Example Walk-Through Scenario:

In a live dealer roulette game at an ETGT, Player 1 consistently bets on single numbers, which are considered high-risk due to their low probability of success. Player 2 places split bets, while Players 3, 4, and 5 focus on safer outside bets like red/black or even/odd.

When the jackpot event is triggered, the system reviews the bets placed by each player. Player 1, who made the riskiest bets on single numbers, receives 50% of the $8,000 jackpot, earning $4,000. Player 2, who placed moderately risky split bets, receives 30%, or $2,400. Players 3, 4, and 5, who made low-risk outside bets, split the remaining $1,600.

This scenario demonstrates how high-risk players are rewarded more generously for their daring wagers, while still allowing all players to receive a portion of the jackpot.

### Example System Procedural Flow:

Bet Tracking: The system tracks all bets placed by players and categorizes them based on their risk level. High-risk bets are flagged for jackpot reward consideration.

Risk Evaluation: When the jackpot is triggered, the system evaluates each player's risk profile based on the bets they placed during the game session.

Reward Calculation: Players who placed high-risk bets receive larger shares of the jackpot, while those who placed lower-risk bets receive smaller portions.

Payout and Display: The system distributes the jackpot based on the risk level of the bets and displays the results on each player's terminal.

Audit and Data Logging: All bet risk data, jackpot calculations, and payouts are recorded in the casino's central network for auditing and reporting.

### Noteworthy Aspects and Features:

Encourages High-Stakes Play: Players are incentivized to take bigger risks in exchange for potentially larger jackpot rewards.

Strategic Gameplay: This technique appeals to players who enjoy strategizing and taking calculated risks during gameplay.

Dynamic Payouts: Jackpot payouts are based on the risk level of each player's bets, adding a dynamic element to the distribution process.

Increased Engagement: Players are motivated to stay engaged and place more adventurous bets, leading to longer play sessions and higher wagering activity.

### Mystery Jackpot Distribution Technique #16—Multi-Game Contribution

### Description and Implementation:

The Multi-Game Contribution technique allows players to accumulate contributions to a shared jackpot across multiple games and tables. This method is ideal for casinos with large gaming networks that want to create a unified jackpot pool spanning multiple game types and locations. Players who contribute to the jackpot fund in one game may still participate in the jackpot payout even if the triggering event occurs in a different game.

The system tracks each player's contributions across various games, such as baccarat, roulette, and blackjack, and combines these contributions into a single jackpot pool. When the jackpot is triggered by any of the linked games, the system allocates the jackpot based on the players' cumulative contributions, regardless of which game they were playing at the time.

### Benefits to Players:

Players benefit from the ability to contribute to and win from a larger, shared jackpot pool across multiple games. This technique provides more opportunities to win and keeps players engaged in various games throughout the casino. Players feel a sense of progress and continuity, knowing that their contributions across different games are building toward a potential jackpot payout. It also adds variety to their gaming experience, as they may switch between games while still working toward a shared goal.

### Benefits to Casinos:

Casinos benefit by encouraging players to participate in multiple games, increasing overall betting activity across the casino floor. The shared jackpot pool helps create excitement and engagement, as players are motivated to continue playing, knowing that any game may trigger the jackpot. This technique also enhances player retention, as players are more to stay within the casino's ecosystem of games rather than leaving to play elsewhere.

### Example Walk-Through Scenario:

In a large casino with multiple ETGTs, players are contributing to a shared jackpot pool across several different games, including roulette, blackjack, and baccarat. Player 1 contributes to the jackpot while playing blackjack, Player 2 contributes while playing roulette, and Players 3, 4, and 5 contribute while playing baccarat.

When the jackpot is triggered by a rare hand combination in blackjack, the system reviews the contributions of all players across the various games. Player 1, having contributed the most while playing blackjack, receives the largest share of the $15,000 jackpot: $6,000. Players 2, 3, 4, and 5 receive smaller shares based on their cumulative contributions across their respective games.

This walk-through demonstrates how the Multi-Game Contribution technique allows players to participate in a shared jackpot pool, creating more opportunities for engagement and excitement across the casino floor.

### Example System Procedural Flow:

Tracking Contributions: The system logs player contributions to the jackpot pool from multiple games and stores this data in a central database.

Linking Games: The system links multiple games and tables to a shared jackpot pool, allowing contributions from different games to accumulate into one jackpot.

Jackpot Trigger: When the jackpot is triggered by any of the linked games, the system identifies the triggering event and calculates each player's share based on their cumulative contributions.

Payout and Display: The system distributes the jackpot to all eligible players across the linked games, displaying their payouts on their respective terminals.

Audit and Logging: All contribution data, jackpot triggers, and payouts are recorded in the casino's central system for auditing and compliance purposes.

### Noteworthy Aspects and Features:

Cross-Game Engagement: Players are encouraged to participate in multiple games, knowing that their contributions are building toward a shared jackpot.

Larger Jackpot Pool: The shared nature of the jackpot pool allows for larger payouts, increasing the excitement and engagement of players.

Flexibility: Players may switch between different games while still contributing to the same jackpot, creating a seamless gaming experience.

Increased Player Retention: The technique keeps players engaged across the casino's ecosystem, encouraging longer play sessions and higher wagering activity.

### Mystery Jackpot Distribution Technique #17—Session-Based Jackpot Share

### Description and Implementation:

The Session-Based Jackpot Share technique allocates the jackpot based on the length of time each player has spent actively participating in a game session. This technique rewards players who commit to longer gaming sessions by giving them a larger share of the jackpot when it is triggered. The system tracks the duration of each player's session and uses this data to calculate the payout distribution.

In an ETGT or LDGT setting, the system continuously monitors how long each player remains active in a game session. When the jackpot is triggered, players who have been participating for longer periods receive larger portions of the jackpot, while newer or shorter-session players receive smaller shares.

### Benefits to Players:

Players benefit from this technique because it rewards their commitment to the game. The longer they stay active, the larger their potential jackpot payout becomes. This provides an incentive for players to remain engaged in the game, knowing that their chances of winning a significant portion of the jackpot increase with time. It also adds a sense of progression, as players feel that their ongoing participation is contributing to their potential rewards.

### Benefits to Casinos:

Casinos benefit by encouraging longer play sessions, which increases overall gaming activity and wager volume. The longer players remain engaged in the game, the more bets they are to place, leading to increased revenue. This technique also helps promote player loyalty, as players who are committed to long sessions are more to return and continue playing in future sessions.

### Example Walk-Through Scenario:

In a live dealer baccarat game at an ETGT, five players are participating. Player 1 has been playing for 90 minutes, Player 2 for 60 minutes, Player 3 for 45 minutes, Player 4 for 30 minutes, and Player 5 just joined the game 10 minutes ago.

When the jackpot event is triggered, the system reviews the session duration of each player. Player 1, who has been playing the longest, receives 50% of the $12,000 jackpot, or $6,000. Player 2, with a 60-minute session, receives 30%, or $3,600. Players 3, 4, and 5 receive smaller portions of the remaining jackpot based on their shorter session durations.

This walk-through demonstrates how the Session-Based Jackpot Share technique rewards players who stay engaged for longer periods, encouraging continued participation in the game.

### Example System Procedural Flow:

Session Time Tracking: The system tracks the duration of each player's session, logging when they start and how long they remain active.

Jackpot Trigger: When the jackpot event is triggered, the system identifies each player's session duration and calculates their share of the jackpot based on the time they've spent in the game.

Payout Process: The system allocates larger portions of the jackpot to players with longer session times, while newer or shorter-session players receive smaller shares.

Display and Payout: The system displays each player's payout on their terminal, along with a summary of how their session time contributed to their jackpot share.

Audit and Data Logging: All session data, jackpot triggers, and payouts are logged for auditing and compliance within the casino's central system.

### Noteworthy Aspects and Features:

Rewards for Commitment: Players are incentivized to remain in the game for longer periods, knowing that their potential rewards increase over time.

Continuous Engagement: The technique promotes ongoing player engagement, leading to longer play sessions and higher wagering activity.

Fair Distribution: Players who have invested more time in the game are rewarded with larger shares of the jackpot, ensuring a fair and balanced payout structure.

Player Retention: By encouraging longer sessions, this technique helps casinos retain players and increase overall game participation.

### Mystery Jackpot Distribution Technique #18—Achievement-Based Jackpot Distribution

### Description and Implementation:

The Achievement-Based Jackpot Distribution technique rewards players based on the completion of specific in-game milestones or achievements. These achievements may be predefined actions, such as winning a certain number of hands in blackjack, landing a rare hand in poker, or hitting a high payout in roulette. The system tracks each player's progress toward these milestones, and when the jackpot is triggered, those who have completed or made the most progress toward the achievements are rewarded with a larger share of the jackpot.

In an ETGT or LDGT environment, players may be notified of their achievement progress in real-time, providing them with an additional incentive to engage more actively in gameplay. Achievements may be linked to various elements of the game, such as bet size, hand combinations, or consecutive wins, giving players multiple avenues to work toward unlocking a larger portion of the jackpot.

### Benefits to Players:

This technique creates a more interactive and goal-driven gaming experience for players. By offering tangible rewards for completing achievements, players are motivated to play more strategically and remain engaged for longer periods. The achievement system also provides a sense of progression, allowing players to track their progress and feel rewarded for their efforts beyond simply winning or losing a hand. Players who enjoy working toward specific goals or objectives will find this technique especially appealing.

### Benefits to Casinos:

For casinos, the achievement-based system encourages longer player sessions and increases betting activity, as players work to complete milestones that will increase their share of the jackpot. It also adds variety to gameplay, keeping players engaged as they strive to complete different achievements across multiple rounds or games.

Additionally, the technique may drive player retention, as players may return to the game to complete unfinished achievements and unlock larger rewards.

### Example Walk-Through Scenario:

In a live dealer poker game at an ETGT, five players are working toward different in-game achievements. Player 1 has won three consecutive hands, qualifying them for the “Winning Streak” achievement. Player 2 has hit several high-value hands, unlocking the “High Roller” achievement. Players 3, 4, and 5 are working toward simpler achievements, such as “Lucky Win” for getting a flush or “Frequent Player” for playing multiple rounds without missing a hand.

When the jackpot is triggered, the system evaluates each player's achievement progress. Player 1, having completed the “Winning Streak” achievement, receives the largest share of the $10,000 jackpot, earning $4,000. Player 2, who unlocked the “High Roller” achievement, receives $3,000. The remaining players, who either completed simpler achievements or were still working toward them, split the remaining $3,000 based on their progress.

This scenario shows how players who complete specific in-game milestones are rewarded with larger jackpot shares, encouraging more strategic and goal-driven play.

### Example System Procedural Flow:

Tracking Achievements: The ETGT or LDGT system monitors each player's progress toward predefined achievements, logging their in-game actions and performance.

Achievement Completion: The system continuously tracks when players complete specific milestones, marking them as eligible for a larger share of the jackpot when it is triggered.

Jackpot Trigger: When the jackpot event occurs, the system evaluates each player's achievement completion status and calculates their share of the jackpot based on their progress.

Payout Process: Players who have completed more or higher-tier achievements receive larger portions of the jackpot. Their payouts are displayed on their terminals, along with a summary of their achievement progress.

Data Logging and Auditing: The system logs all achievement progress, jackpot calculations, and payouts in the casino's central network for auditing and compliance purposes.

### Noteworthy Aspects and Features:

Goal-Oriented Gameplay: Players are rewarded for completing in-game achievements, creating a more interactive and goal-driven gaming experience.

Increased Engagement: The system encourages players to remain engaged and work toward specific objectives, driving longer sessions and higher betting activity.

Strategic Play: Players are motivated to play more strategically to complete milestones and unlock larger jackpot rewards.

Retention Incentive: Players may return to the game to complete unfinished achievements, promoting player retention and repeat visits.

### Mystery Jackpot Distribution Technique #19—Dynamic Bet Contribution

### Description and Implementation:

The Dynamic Bet Contribution technique allocates the jackpot based on the changing value of each player's bets over time. Instead of only considering the cumulative total or last bet size, this method tracks the fluctuations in a player's wager amounts during gameplay, rewarding those who demonstrate more dynamic and aggressive betting behavior. Players who progressively increase their bets over the course of a session, or who strategically vary their wagers, are given a larger share of the jackpot when it is triggered.

In an ETGT or LDGT environment, this technique introduces a new layer of strategy, as players are incentivized to adjust their bets dynamically rather than sticking to a consistent wager size. The system tracks bet sizes in real-time and applies weighting to those bets that reflect greater risk-taking or variation, ensuring that the most dynamic players are rewarded.

### Benefits to Players:

Players benefit from this technique as it rewards them for strategic, dynamic betting rather than just high-stakes or consistent wagers. It adds a layer of excitement to gameplay, as players are encouraged to change their bet sizes and take more risks to increase their potential jackpot share. This method also rewards players who are actively engaged in the game, making frequent adjustments to their betting strategy based on their perception of the game's flow.

### Benefits to Casinos:

Casinos benefit by encouraging players to increase their bet sizes over time, leading to higher overall wager volumes. The dynamic nature of this technique fosters more engagement, as players are constantly adjusting their bets in pursuit of a larger jackpot share. Additionally, the strategy involved in dynamic betting may lead to longer play sessions, as players remain invested in their changing fortunes and work to optimize their betting behavior.

### Example Walk-Through Scenario:

In a live dealer blackjack game at an ETGT, five players are participating. Player 1 starts with a modest bet of $50 but gradually increases their bet to $200 over the course of the session, demonstrating dynamic bet progression.

Player 2, in contrast, sticks to a consistent $100 bet throughout the game, while Player 3 places varied bets, ranging from $25 to $150, based on the hand outcome. Players 4 and 5 place smaller, consistent wagers of $10 to $50.

When the jackpot event is triggered, the system reviews the bet history of each player. Player 1, who demonstrated the most dynamic bet increases, receives 40% of the $8,000 jackpot, earning $3,200. Player 3, who varied their bets strategically, receives 30%, or $2,400. Player 2, with consistent betting, receives 20%, or $1,600. Players 4 and 5 receive smaller portions of the jackpot based on their more conservative, static betting.

This walk-through demonstrates how dynamic betting behavior is rewarded with larger jackpot shares, encouraging players to vary their bets and take calculated risks.

### Example System Procedural Flow:

Bet Tracking: The system tracks each player's bet amounts in real-time, recording how they fluctuate over the course of the game.

Dynamic Bet Weighting: The system assigns weight to bets that increase in size or vary strategically, giving greater value to those that reflect dynamic betting behavior.

Jackpot Trigger: When the jackpot event is triggered, the system calculates each player's share based on the dynamic weighting of their bet history.

Payout Process: Players with more dynamic and varied bet histories receive larger portions of the jackpot. Their payouts are displayed on their terminals, along with a summary of their betting behavior.

Data Logging and Auditing: All bet data, dynamic weighting calculations, and payouts are logged in the casino's central network for auditing and reporting.

### Noteworthy Aspects and Features:

Rewards Strategic Betting: Players who adjust their bet sizes dynamically are rewarded with larger jackpot shares, encouraging strategic play.

Increased Wager Volume: The technique incentivizes players to increase their bets over time, leading to higher overall wager amounts.

Real-Time Engagement: Players are constantly engaged in adjusting their betting strategy, leading to more active participation in the game.

Exciting Gameplay: The dynamic nature of this technique keeps the gameplay exciting, as players work to optimize their bet progression for greater rewards.

### Mystery Jackpot Distribution Technique #20—Community Pool Contribution

### Description and Implementation:

The Community Pool Contribution technique rewards players based on their contribution to a shared community pool that grows over time. In this method, players' bets contribute to a communal jackpot fund, and when the jackpot is triggered, the pool is distributed among all participants. The notable feature of this technique is that players are not only working for individual rewards but also contributing to a shared goal that benefits the entire player community.

The system tracks each player's contribution to the community pool, which grows with every round of play. When the jackpot is triggered, the total amount in the community pool is distributed proportionally to players based on their contributions. This technique may be applied across multiple tables or ETGTs, creating a shared experience that unites players across different games.

### Benefits to Players:

Players benefit from the sense of camaraderie and shared achievement that comes with contributing to and winning from a community pool. The technique fosters a cooperative atmosphere, as players know their contributions are building toward a collective jackpot that will benefit everyone. This method also ensures that even low-stakes players receive a portion of the jackpot, as every contribution counts toward the final payout.

### Benefits to Casinos:

Casinos benefit by increasing player engagement and encouraging longer play sessions, as players are motivated to continue contributing to the community pool. The sense of shared progress keeps players invested in the game, as they know their efforts are working toward a larger collective reward. The technique also promotes social interaction, which may enhance the overall gaming experience and lead to higher player retention.

### Example Walk-Through Scenario:

In a live dealer baccarat game at an ETGT, five players are contributing to a community jackpot pool. Player 1 contributes $500 over the course of the session, while Player 2 contributes $300, and Players 3, 4, and 5 contribute $200, $100, and $50, respectively. The community pool grows to $12,000 by the time the jackpot is triggered.

When the jackpot event occurs, the system calculates each player's share based on their contributions to the community pool. Player 1, having contributed the most, receives $5,000. Player 2 receives $3,000, while Players 3, 4, and 5 receive $2,000, $1,000, and $500, respectively.

This walk-through demonstrates how the Community Pool Contribution technique rewards players based on their collective efforts, fostering a sense of shared achievement.

### Example System Procedural Flow:

Community Pool Tracking: The system tracks each player's contributions to the shared community pool over the course of the game.

Pool Growth: With each round, players' bets contribute to the community pool, which grows in value as the game progresses.

Jackpot Trigger: When the jackpot event is triggered, the system calculates each player's share based on their total contribution to the community pool.

Payout Process: The system distributes the community pool to all participants, with larger portions going to players who contributed more. The payouts are displayed on each player's terminal.

Audit and Reporting: All contribution data, pool growth, and jackpot payouts are logged in the casino's central system for auditing and compliance purposes.

### Noteworthy Aspects and Features:

Fosters Cooperation: Players work together to build the community pool, creating a cooperative and inclusive gaming experience.

Shared Progress: The community pool grows with every round, providing a sense of progress and continuity for all participants.

Inclusive Rewards: Even low-stakes players benefit from the jackpot, as every contribution counts toward the final payout.

Social Interaction: The technique encourages social interaction and camaraderie among players, enhancing the overall gaming experience.

### Mystery Jackpot Distribution Technique #21—Time-Limited Jackpot Window

### Description and Implementation:

The Time-Limited Jackpot Window technique allows players to qualify for a share of the jackpot only if they are actively playing during a specific, time-limited window when the jackpot event occurs. This method creates urgency and excitement, as players may be engaged during the jackpot window to be eligible for a payout. The time window may be set for specific intervals during gameplay, such as every 30 minutes, or it may be triggered by specific in-game events.

In an ETGT or LDGT environment, the system notifies players when the jackpot window is approaching, prompting them to place their bets or continue playing to qualify. If the jackpot is triggered during the active window, only players who placed bets during that time period are eligible to receive a share.

### Benefits to Players:

Players benefit from the increased excitement and anticipation created by the time-limited window. Knowing they may be actively engaged during specific periods keeps players on their toes and encourages them to stay in the game for longer periods. This technique also adds an extra layer of strategy, as players may choose to increase their betting activity leading up to the jackpot window to maximize their chances of qualifying.

### Benefits to Casinos:

For casinos, this technique increases player engagement and extends play sessions, as players are incentivized to stay active and place bets during the jackpot window. The urgency of the time-limited window drives higher betting activity, as players rush to qualify for the jackpot. This method also helps casinos manage player traffic, encouraging participation during peak times or slower periods by strategically scheduling jackpot windows.

### Example Walk-Through Scenario:

In a live dealer roulette game at an ETGT, five players are notified that a jackpot window will open in the next five minutes. Players 1, 2, and 3 increase their bet sizes, while Players 4 and 5 maintain their standard bets. The system tracks all bets placed during the time-limited window.

When the jackpot event is triggered within the window, only Players 1, 2, and 3, who placed bets during the jackpot window, qualify for a share of the $10,000 jackpot. Player 1, with the largest bet, receives $5,000. Player 2 receives $3,000, and Player 3 receives $2,000. Players 4 and 5, who did not place qualifying bets during the window, are ineligible for the jackpot.

This walk-through shows how the Time-Limited Jackpot Window technique encourages players to stay active and place bets during specific time periods, creating excitement and urgency.

### Example System Procedural Flow:

Jackpot Window Notification: The system notifies players of the upcoming jackpot window, prompting them to place their bets or stay engaged in the game.

Tracking Bets: The system tracks all bets placed during the jackpot window, logging the qualifying players and their bet amounts.

Jackpot Trigger: When the jackpot event is triggered during the window, the system calculates each player's share based on their qualifying bet amounts.

Payout Process: Only players who placed qualifying bets during the window receive a share of the jackpot, with larger shares going to those who placed larger bets.

Audit and Logging: All bet data, qualifying players, and jackpot payouts are logged in the casino's central system for auditing and compliance purposes.

### Noteworthy Aspects and Features:

Creates Urgency: Players are incentivized to place bets and stay engaged during specific time windows to qualify for the jackpot.

Increases Betting Activity: The time-limited nature of the window encourages players to increase their bets during the qualifying period, driving higher wager volumes.

Strategic Play: Players may adjust their betting strategy based on the timing of the jackpot window, adding an extra layer of excitement to the game.

Extends Play Sessions: The technique encourages players to stay in the game for longer periods, as they wait for the jackpot window to open.

### Mystery Jackpot Distribution Technique #22—Jackpot Split by Player Ranks

### Description and Implementation:

The Jackpot Split by Player Ranks technique distributes the jackpot based on a ranking system that reflects each player's overall performance in the game. Players are assigned ranks according to specific performance metrics, such as total winnings, number of hands won, or other game-specific achievements. Higher-ranked players receive larger portions of the jackpot when it is triggered, while lower-ranked players receive smaller shares.

In an ETGT or LDGT environment, the ranking system may be updated in real-time, with each player's rank being visible on their terminal or a shared leaderboard. The system tracks the performance of all players across the session and adjusts ranks dynamically. When the jackpot event occurs, the system allocates shares of the jackpot according to the final rankings.

### Benefits to Players:

Players benefit from the added competitiveness and motivation that comes with a ranking system. Higher-ranked players are rewarded for their superior performance, while lower-ranked players are incentivized to improve their gameplay in pursuit of a larger share of the jackpot. This technique fosters a sense of progression and achievement, as players may see their rank change throughout the session, giving them something tangible to work toward.

### Benefits to Casinos:

For casinos, this technique promotes player engagement and encourages competitive play. The ranking system keeps players focused on improving their performance, which may lead to longer sessions and higher betting activity.

The dynamic nature of the ranks keeps the game exciting, as players know their jackpot share will depend on their rank at the time the jackpot is triggered. The competitive atmosphere this system creates may also enhance the overall player experience, driving repeat visits and player loyalty.

### Example Walk-Through Scenario:

In a live dealer blackjack game at an ETGT, five players are participating. Player 1 has won the most hands and placed the largest bets, earning them the top rank. Player 2 has also performed well, ranking second, while Players 3, 4, and 5 have won fewer hands and placed smaller bets, putting them in the lower ranks.

When the jackpot event is triggered, the system allocates the $15,000 jackpot according to the player rankings. Player 1, with the highest rank, receives 50% of the jackpot, earning $7,500. Player 2 receives 30%, or $4,500. Players 3, 4, and 5 receive smaller portions of the remaining jackpot based on their lower ranks.

This walk-through demonstrates how the Jackpot Split by Player Ranks technique rewards higher performance with larger payouts, encouraging players to strive for the top ranks to maximize their rewards.

### Example System Procedural Flow:

Tracking Player Performance: The ETGT or LDGT system tracks each player's performance metrics in real-time, including hands won, bets placed, and other relevant data.

Rank Assignment: The system dynamically assigns ranks to players based on their performance. These ranks are updated throughout the game session as players' performance changes.

Jackpot Trigger: When the jackpot event is triggered, the system calculates each player's share of the jackpot based on their final rank at the time of the trigger.

Payout Process: Higher-ranked players receive larger shares of the jackpot, while lower-ranked players receive smaller portions. The payouts are displayed on each player's terminal, along with their final rank.

Data Logging and Auditing: The system logs all performance data, ranking calculations, and jackpot payouts for auditing and compliance within the casino's central network.

### Noteworthy Aspects and Features:

Competitive Motivation: The ranking system encourages players to perform better and improve their gameplay to achieve higher ranks and larger jackpot shares.

Dynamic Gameplay: The ranks are updated in real-time, keeping the game engaging and competitive as players work to improve their standing.

Incentivizes Performance: The technique rewards superior performance, creating a sense of progression and achievement.

Increased Betting Activity: Players are motivated to place larger bets and stay engaged for longer periods in pursuit of higher ranks and bigger rewards.

### Mystery Jackpot Distribution Technique #23—Progressive Jackpot Tiers

### Description and Implementation:

The Progressive Jackpot Tiers technique divides the jackpot into multiple tiers, with each tier being unlocked as the jackpot grows in size. Players qualify for different tiers of the jackpot based on their bet sizes or in-game achievements, with higher tiers offering larger rewards. The system tracks the growth of the jackpot and allocates it across the various tiers, ensuring that the larger, more valuable tiers are only unlocked when the jackpot reaches certain thresholds.

In an ETGT or LDGT environment, this technique is ideal for games with progressive jackpots that grow over time. Players are notified when they qualify for a higher tier based on their bet size or gameplay, giving them an incentive to increase their wagers or achieve specific milestones. The system automatically allocates the jackpot based on the player's qualifying tier when the event is triggered.

### Benefits to Players:

Players benefit from this technique by having the opportunity to unlock larger rewards as the jackpot grows. The tiered system provides a sense of progression, with players knowing that their chances of winning bigger payouts increase as they move up through the tiers. This method also encourages players to place higher bets or pursue specific achievements to qualify for the upper tiers, adding excitement and motivation to their gameplay.

### Benefits to Casinos:

For casinos, the Progressive Jackpot Tiers technique drives higher betting activity, as players are motivated to place larger wagers to qualify for higher jackpot tiers. This system also encourages longer play sessions, as players stay engaged in the hopes of reaching the next tier before the jackpot is triggered. The tiered structure allows casinos to manage the distribution of large jackpots more effectively, ensuring that larger payouts are only made when the jackpot pool is substantial.

### Example Walk-Through Scenario:

In a live dealer baccarat game, the progressive jackpot has reached $20,000, and the system divides it into three tiers: Tier 1 for bets under $50, Tier 2 for bets between $50 and $200, and Tier 3 for bets over $200. Player 1 consistently bets $250 per round, qualifying them for Tier 3, while Player 2 bets $100 per round, qualifying for Tier 2. Players 3, 4, and 5 place smaller bets, qualifying for Tier 1.

When the jackpot event is triggered, the system allocates the jackpot according to the player tiers. Player 1, in the highest tier, receives 50% of the jackpot, earning $10,000. Player 2, in Tier 2, receives 30%, or $6,000. Players 3, 4, and 5, in Tier 1, share the remaining 20%, with each receiving $1,333.

This scenario illustrates how the Progressive Jackpot Tiers technique rewards players who qualify for higher tiers with larger payouts, encouraging them to place larger bets to unlock the biggest rewards.

### Example System Procedural Flow:

Tracking Bets and Achievements: The ETGT or LDGT system monitors player bet sizes and gameplay achievements, determining which players qualify for each jackpot tier.

Jackpot Growth and Tier Unlocking: As the jackpot grows, higher tiers are unlocked, allowing players who qualify for these tiers to receive larger payouts.

Jackpot Trigger: When the jackpot is triggered, the system allocates the total jackpot across the different tiers, ensuring that players in higher tiers receive larger portions of the pool.

Payout Process: The system distributes the jackpot according to the player's qualifying tier. The payouts are displayed on each player's terminal, along with their tier status.

Audit and Logging: All bet data, tier qualifications, and jackpot payouts are logged in the casino's central network for compliance and reporting purposes.

### Noteworthy Aspects and Features:

Incentivizes Higher Bets: Players are encouraged to place larger bets or achieve specific milestones to qualify for higher jackpot tiers.

Progressive Structure: The tiered system provides a sense of progression, with larger rewards available as the jackpot grows.

Fair Distribution: The jackpot is allocated proportionally across the tiers, ensuring that players in higher tiers receive larger shares while lower-tier players still benefit.

Engages All Players: The system keeps all players engaged, as even those in lower tiers have the opportunity to win a share of the jackpot.

### Mystery Jackpot Distribution Technique #24—Last Winner Bonus

### Description and Implementation:

The Last Winner Bonus technique allocates an extra portion of the jackpot to the player who was the most recent winner of the main game or a specific in-game bonus round. This method rewards players who have recently experienced success, giving them an additional incentive to maintain their winning streak. The system tracks the most recent winners and reserves a special bonus portion of the jackpot for them when the event is triggered.

In an ETGT or LDGT setup, the system automatically designates the last winner based on the outcome of the most recent hand, spin, or round. This player is then awarded a larger share of the jackpot, in addition to any other distribution methods in place. The Last Winner Bonus may be integrated into games such as roulette, blackjack, or poker, where winners are determined frequently throughout the session.

### Benefits to Players:

Players benefit from this technique as it gives them a special reward for their recent success, encouraging them to keep playing and striving for more wins. The Last Winner Bonus adds excitement to the game, as players know that their next win may lead to a significant jackpot boost. It also incentivizes players to stay active in the game, knowing that winning a round may put them in line for a larger share of the jackpot.

### Benefits to Casinos:

Casinos benefit by increasing player retention and engagement, as players are motivated to continue playing after winning a round in the hopes of securing the Last Winner Bonus. This technique keeps players invested in the game, leading to longer sessions and higher wager volumes. The added excitement of potentially winning a bonus share of the jackpot encourages players to remain focused and competitive, enhancing the overall gaming experience.

### Example Walk-Through Scenario:

In a live dealer roulette game, Player 3 wins the most recent round by betting on a single number, earning a substantial payout. When the jackpot is triggered on the following round, Player 3, as the most recent winner, qualifies for the Last Winner Bonus, receiving an extra 20% of the $10,000 jackpot, or $2,000.

The remaining $8,000 is distributed among all other qualifying players based on their bet sizes. Player 1, with the largest bet, receives $4,000, while Players 2, 4, and 5 split the remaining $4,000 based on their contributions.

This scenario demonstrates how the Last Winner Bonus rewards players for recent wins, adding extra excitement and incentive to keep playing after a successful round.

### Example System Procedural Flow:

Tracking Recent Winners: The system monitors the outcomes of each round and designates the most recent winner based on the game's rules.

Bonus Allocation: When the jackpot event is triggered, the system reserves a special portion of the jackpot for the most recent winner, in addition to their regular share.

Jackpot Trigger: The system triggers the jackpot and allocates the Last Winner Bonus to the designated player, while the rest of the jackpot is distributed according to other qualifying factors.

Payout Process: The system displays the bonus payout to the last winner, along with the regular jackpot distribution for all other players.

Audit and Logging: All winner data, bonus allocations, and jackpot payouts are logged in the casino's central network for auditing and compliance.

### Noteworthy Aspects and Features:

Encourages Winning Streaks: Players are motivated to continue winning rounds to qualify for the Last Winner Bonus, driving more competitive play.

Boosts Engagement: The technique keeps players engaged after winning a round, as they know their next win may lead to a jackpot bonus.

Simple Integration: The Last Winner Bonus is easy to integrate into most games, as it only may require tracking the most recent winner.

Extra Excitement: The potential for a bonus share of the jackpot adds extra excitement to every round, keeping players focused and invested.

### Mystery Jackpot Distribution Technique #25—Jackpot Rollover

### Description and Implementation:

The Jackpot Rollover technique carries over a portion of the jackpot from one session to the next if no players qualify for a full payout. In this system, a percentage of the jackpot is reserved and added to the starting jackpot for the next gaming session, creating progressively larger jackpot opportunities. This technique is commonly used in progressive jackpot systems, where the jackpot pool grows until a winning event occurs.

In an ETGT or LDGT setting, the system monitors each session and reserves a portion of the jackpot if no one qualifies for a full payout based on predefined conditions. The rollover amount is added to the next session's jackpot, encouraging players to stay engaged as the potential reward increases over time.

### Benefits to Players:

Players benefit from the excitement of seeing the jackpot grow larger with each rollover, increasing their motivation to participate in the next session. The possibility of winning a larger jackpot keeps players engaged, as they know the prize pool will continue to increase until it is won. This technique also creates a sense of anticipation, as players eagerly await the moment when the jackpot reaches its peak and becomes winnable.

### Benefits to Casinos:

For casinos, the Jackpot Rollover technique drives longer play sessions and higher player retention, as players are motivated to return for future sessions in pursuit of the growing jackpot. The increasing jackpot pool also encourages higher betting activity, as players are more willing to place larger bets when they know the potential payout is significant. Additionally, the rollover system allows casinos to manage jackpot distribution more effectively, ensuring that larger jackpots are only paid out when the conditions are met.

### Example Walk-Through Scenario:

In a live dealer blackjack game, no players qualify for a full payout based on the predefined jackpot conditions. As a result, the system reserves 30% of the $12,000 jackpot, or $3,600, to be rolled over to the next session. The remaining $8,400 is distributed among the players who placed qualifying bets.

In the next session, the starting jackpot is increased by the rollover amount, growing the pool to $13,600. Players are more motivated to participate, knowing that the jackpot has increased significantly and may continue to grow if not won in this session.

This walk-through demonstrates how the Jackpot Rollover technique increases player engagement and excitement as the jackpot grows larger with each session.

### Example System Procedural Flow:

Monitoring Jackpot Conditions: The system monitors each session to determine if the jackpot conditions are met for a full payout.

Rollover Calculation: If no players qualify for a full payout, the system reserves a portion of the jackpot to be rolled over to the next session.

Jackpot Rollover: The system adds the reserved portion to the next session's starting jackpot, increasing the total pool for future players.

Payout Process: The remaining jackpot is distributed to any players who qualify based on their contributions or other predefined conditions.

Logging and Auditing: All rollover calculations, jackpot reserves, and payouts are logged in the casino's central system for auditing and compliance purposes.

### Noteworthy Aspects and Features:

Growing Jackpot Excitement: Players are motivated to participate in future sessions as the jackpot continues to grow with each rollover.

Encourages Higher Bets: The larger jackpot pool encourages players to place larger bets in pursuit of the growing prize.

Retention Incentive: The rollover system encourages player retention, as players return for future sessions in hopes of winning the bigger jackpot.

Effective Jackpot Management: The technique allows casinos to manage jackpot distribution by ensuring that larger payouts are only made when specific conditions are met.

### Mystery Jackpot Distribution Technique #26—Player Lottery Draw

### Description and Implementation:

The Player Lottery Draw technique distributes the jackpot through a random lottery-style drawing among eligible players. This method involves selecting one or more winners from a pool of players who have qualified for the draw by meeting certain conditions, such as placing a minimum bet or achieving a specific in-game milestone. Unlike pure random selection, where every player is eligible, the lottery draw ensures that only players who have met the predetermined criteria participate in the jackpot distribution.

In an ETGT or LDGT environment, the system tracks the players who qualify for the lottery draw throughout the game session. At the end of the session, or when the jackpot event is triggered, the system conducts a random draw to determine the winner(s) of the jackpot. The draw may be based on virtual “tickets” that players earn by meeting certain conditions, with more tickets providing a greater chance of winning.

### Benefits to Players:

Players benefit from a clear and engaging reward structure, as they know exactly what conditions they need to meet to qualify for the lottery draw. This technique introduces an element of suspense and excitement, as players may earn more lottery tickets to improve their odds of winning the jackpot. It also appeals to players who enjoy the thrill of lotteries and random draws, offering a fair chance to all qualifying participants while still rewarding active and strategic play.

### Benefits to Casinos:

Casinos benefit by encouraging players to meet specific in-game conditions, such as placing minimum bets or achieving milestones, to qualify for the lottery draw. This leads to higher engagement and longer play sessions as players work to maximize their chances of winning. The lottery draw format also adds excitement and unpredictability to the game, making it more appealing to a broad range of players. Additionally, this technique allows casinos to control the jackpot distribution by setting clear conditions for entry, ensuring that only qualified players participate.

### Example Walk-Through Scenario:

In a live dealer baccarat game at an ETGT, five players are participating. To qualify for the lottery draw, players must place a minimum bet of $100 per round or win a hand with a specific card combination. Player 1 places qualifying bets in each round and earns five lottery tickets. Player 2 wins a hand with a rare card combination, earning two tickets, while Players 3, 4, and 5 earn one ticket each through their betting activity.

When the jackpot event is triggered, the system conducts a random lottery draw using the tickets each player has earned. Player 1, with the most tickets, has the highest chance of winning but is not guaranteed. The system randomly selects Player 3 as the winner of the $10,000 jackpot, rewarding them based on luck rather than pure performance.

This scenario shows how the Player Lottery Draw technique balances skill and chance, giving all qualifying players a fair opportunity to win while still rewarding those who meet the conditions more frequently.

### Example System Procedural Flow:

Tracking Qualifying Conditions: The system tracks each player's actions to determine which players meet the conditions for earning lottery tickets, such as minimum bet sizes or winning specific hands.

Lottery Ticket Allocation: The system allocates virtual lottery tickets to players based on the number of qualifying actions they complete during the game session.

Jackpot Trigger: When the jackpot event is triggered, the system initiates the lottery draw process, selecting one or more winners from the pool of players who have earned tickets.

Payout Process: The system distributes the jackpot to the randomly selected player(s), displaying the results on their terminals and announcing the outcome to all players.

Audit and Logging: All lottery ticket data, draw results, and jackpot payouts are logged in the casino's central system for auditing and compliance purposes.

### Noteworthy Aspects and Features:

Fair and Engaging: The lottery draw provides all qualified players with a chance to win, creating a fair and exciting reward structure.

Encourages Participation: Players are motivated to meet the conditions for earning lottery tickets, driving higher betting activity and engagement.

Balances Skill and Chance: The system rewards both strategic play and luck, appealing to a wide range of players.

Simple and Transparent: The clear rules for qualifying and the random draw format make the jackpot distribution process easy to understand and follow.

### Mystery Jackpot Distribution Technique #27—Incremental Contribution Share

### Description and Implementation:

The Incremental Contribution Share technique distributes the jackpot based on the incremental growth of each player's bet contributions over time. This method tracks how much each player has contributed to the jackpot pool across multiple rounds or sessions and rewards players proportionally based on their contributions. The system emphasizes consistent and increasing contributions, giving players who raise their bets over time a larger share of the jackpot.

In an ETGT or LDGT setting, the system monitors each player's contributions to the jackpot pool, tracking how their bet sizes change over time. Players who consistently increase their bet amounts are given a larger portion of the jackpot when it is triggered. This technique rewards steady and progressive betting behavior, encouraging players to increase their wagers gradually throughout the game.

### Benefits to Players:

Players benefit from this technique by having their incremental bet increases rewarded, rather than just focusing on their total wager amount. This encourages players to adopt a progressive betting strategy, where they gradually increase their bets to maximize their potential jackpot share. It also provides a sense of progression, as players may see their contributions to the jackpot pool grow over time and know that their efforts are directly tied to their potential reward.

### Benefits to Casinos:

For casinos, the Incremental Contribution Share technique drives higher betting activity, as players are incentivized to increase their wagers progressively. This leads to greater overall contributions to the jackpot pool, increasing the potential payout and excitement for all players. The technique also promotes longer play sessions, as players remain engaged in the hopes of maximizing their jackpot share through consistent and incremental contributions.

### Example Walk-Through Scenario:

In a live dealer roulette game, five players are contributing to the jackpot pool. Player 1 starts with a $50 bet and gradually increases it to $150 over the course of the session. Player 2 begins with a $100 bet and increases it to $200, while Players 3, 4, and 5 maintain consistent bet sizes of $50 to $75.

When the jackpot event is triggered, the system reviews the incremental contributions of each player. Player 2, who contributed the most incrementally, receives 40% of the $12,000 jackpot, earning $4,800. Player 1, who also increased their bets steadily, receives 30%, or $3,600. The remaining players, with smaller or less dynamic contributions, share the remaining $3,600 based on their incremental bet history.

This scenario shows how the Incremental Contribution Share technique rewards players for gradually increasing their bets, encouraging strategic wagering behavior.

### Example System Procedural Flow:

Tracking Bet Increases: The system monitors each player's bet amounts over the course of the session, tracking how their contributions to the jackpot pool change incrementally.

Contribution Weighting: The system assigns more weight to players who increase their bets progressively, calculating their potential share of the jackpot accordingly.

Jackpot Trigger: When the jackpot event is triggered, the system calculates each player's share based on their incremental contributions to the jackpot pool.

Payout Process: Players who increased their bets more significantly receive larger portions of the jackpot. The payouts are displayed on each player's terminal.

Audit and Logging: The system logs all bet data, incremental contribution calculations, and jackpot payouts in the casino's central system for auditing and compliance purposes.

### Noteworthy Aspects and Features:

Encourages Progressive Betting: Players are incentivized to increase their bets over time, driving more dynamic and strategic wagering behavior.

Rewards Consistency: The technique rewards players who steadily increase their contributions, promoting longer play sessions.

Fair Distribution: The jackpot is distributed proportionally based on each player's incremental contributions, ensuring that consistent effort is rewarded.

Increased Engagement: The sense of progression and the potential for larger rewards keep players engaged throughout the game.

### Mystery Jackpot Distribution Technique #28—Tournament-Based Jackpot Distribution

### Description and Implementation:

The Tournament-Based Jackpot Distribution technique allocates the jackpot based on the results of a special in-game tournament or competition. Players compete in a designated tournament round or series of rounds, and the jackpot is distributed to the winners or top performers. This technique is particularly well-suited for multiplayer games such as poker, blackjack, or baccarat, where players may compete directly against one another for a portion of the jackpot.

In an ETGT or LDGT setup, the system tracks player performance throughout the tournament, assigning ranks or points based on their performance in each round. When the jackpot event is triggered, the system distributes the jackpot according to the final tournament standings. The top-ranked players receive the largest shares, while lower-ranked players may receive smaller portions or no payout, depending on the tournament rules.

### Benefits to Players:

Players benefit from the competitive nature of the tournament format, which allows them to directly influence their potential jackpot payout through skillful play. The tournament structure adds an extra layer of excitement to the game, as players work to outplay their opponents and secure the top spots on the leaderboard. This technique also appeals to players who enjoy a more strategic and skill-based gaming experience, as their performance in the tournament directly determines their share of the jackpot.

### Benefits to Casinos:

For casinos, the Tournament-Based Jackpot Distribution technique drives higher player engagement and longer sessions, as players remain focused on performing well in the tournament. The competitive format encourages more aggressive and strategic betting behavior, leading to increased wager volumes. Additionally, the tournament structure may attract players who enjoy skill-based competition, helping casinos differentiate their offerings and appeal to a broader range of players.

### Example Walk-Through Scenario:

In a live dealer poker tournament at an ETGT, five players are competing for a share of the $15,000 jackpot. The system tracks each player's performance across multiple rounds, awarding points based on hands won and bet sizes. Player 1 consistently wins the most hands, securing the top spot on the leaderboard. Player 2 performs well but places second, while Players 3, 4, and 5 finish in lower positions.

When the tournament ends and the jackpot event is triggered, the system distributes the jackpot based on the final standings. Player 1, as the tournament winner, receives 50% of the jackpot, or $7,500. Player 2 receives 30%, or $4,500, while Players 3, 4, and 5 split the remaining $3,000 based on their performance.

This scenario demonstrates how the Tournament-Based Jackpot Distribution technique rewards skillful play, allowing top performers to win larger portions of the jackpot.

### Example System Procedural Flow:

Tracking Tournament Performance: The system tracks each player's performance throughout the tournament, awarding points based on wins, bets, and other relevant metrics.

Leaderboard Management: The system updates the leaderboard in real-time, displaying each player's rank based on their cumulative performance in the tournament.

Jackpot Trigger: When the tournament ends and the jackpot event is triggered, the system distributes the jackpot according to the final tournament standings.

Payout Process: The top-ranked players receive larger portions of the jackpot, while lower-ranked players receive smaller shares or no payout, depending on the rules.

Audit and Logging: All tournament data, leaderboard standings, and jackpot payouts are logged in the casino's central system for auditing and compliance.

### Noteworthy Aspects and Features:

Competitive Gameplay: The tournament format encourages direct competition between players, driving engagement and excitement.

Skill-Based Rewards: Players are rewarded based on their performance, making this technique appealing to those who enjoy strategic, skill-based play.

Dynamic and Engaging: The leaderboard and tournament structure keep players engaged throughout the competition, promoting longer play sessions.

Increased Wager Volume: The competitive nature of the tournament encourages more aggressive betting, leading to higher overall wager amounts.

### Mystery Jackpot Distribution Technique #29—Secret Criteria Jackpot Distribution

### Description and Implementation:

The Secret Criteria Jackpot Distribution technique introduces an element of mystery by awarding the jackpot based on hidden, undisclosed criteria. Players do not know the specific conditions that may be met to win a portion of the jackpot, which creates an air of suspense and unpredictability. The secret criteria may involve specific betting patterns, hand outcomes, or gameplay milestones, but they are only revealed to players after the jackpot is triggered.

In an ETGT or LDGT environment, the system monitors all player activity throughout the session, checking for fulfillment of the secret criteria. When the jackpot event is triggered, the system identifies which players met the hidden conditions and distributes the jackpot accordingly. Players are then informed of the criteria, adding an exciting twist to the game as they see whether their actions aligned with the jackpot requirements.

### Benefits to Players:

Players benefit from the excitement and intrigue created by the secret criteria. This technique keeps players guessing and engaged, as they don't know exactly what they need to do to qualify for the jackpot. It adds an element of surprise to the game, as players only discover the criteria after the jackpot is triggered, making the experience more thrilling. The unknown criteria also encourage players to experiment with different strategies in the hopes of meeting the hidden conditions.

### Benefits to Casinos:

For casinos, the Secret Criteria Jackpot Distribution technique drives higher engagement and betting activity, as players are motivated to try different strategies in pursuit of the hidden jackpot criteria. The mystery element adds excitement and unpredictability to the game, keeping players entertained and invested in the outcome. This technique also allows casinos to control the frequency of jackpot payouts by adjusting the difficulty of the secret criteria, ensuring that jackpots are awarded at an optimal rate.

### Example Walk-Through Scenario:

In a live dealer baccarat game at an ETGT, five players are participating. Unknown to the players, the secret criteria for winning the jackpot involve placing a bet on a tie outcome and winning three consecutive hands. The system tracks all player actions but does not reveal the criteria.

When the jackpot event is triggered, the system reviews the players' actions and identifies that Player 2 met the hidden criteria by placing a bet on a tie and winning three hands in a row. Player 2 is awarded the entire $8,000 jackpot, and the secret criteria are revealed to all players, adding an element of surprise and excitement to the game.

This walk-through demonstrates how the Secret Criteria Jackpot Distribution technique creates suspense and intrigue, keeping players engaged as they try to uncover the hidden jackpot conditions.

### Example System Procedural Flow:

Setting Secret Criteria: The system establishes hidden criteria for qualifying for the jackpot, such as specific betting patterns or gameplay outcomes.

Monitoring Player Activity: The system tracks all player actions throughout the session, checking for fulfillment of the secret criteria without revealing them to the players.

Jackpot Trigger: When the jackpot event is triggered, the system identifies which players met the secret criteria and allocates the jackpot accordingly.

Revealing the Criteria: After the jackpot is awarded, the system reveals the secret criteria to all players, adding an element of surprise to the game.

Audit and Logging: All player actions, secret criteria fulfillment, and jackpot payouts are logged in the casino's central system for auditing and compliance purposes.

### Noteworthy Aspects and Features:

Element of Surprise: The hidden criteria add excitement and unpredictability to the game, keeping players engaged and entertained.

Encourages Experimentation: Players are motivated to try different strategies in the hopes of meeting the secret jackpot conditions.

Flexible Jackpot Control: Casinos may adjust the difficulty of the secret criteria to control the frequency of jackpot payouts.

Suspenseful Gameplay: The unknown criteria create suspense, making the moment of jackpot revelation more thrilling for all participants.

### Mystery Jackpot Distribution Technique #30—Jackpot Proximity Reward

### Description and Implementation:

The Jackpot Proximity Reward technique distributes a portion of the jackpot to players who are in close physical proximity to the player who triggers the jackpot. This method introduces a social and spatial element to the jackpot distribution, where nearby players are rewarded simply by being in the same area as the winning player. The proximity may be determined by physical seating in a Live Dealer Game Table (LDGT) environment or virtual seat positions in an Electronic Table Game Terminal (ETGT) setting.

The system tracks the seating arrangements of all players and calculates which ones are within the proximity range of the jackpot winner. When the jackpot event is triggered, the system allocates a predefined percentage of the jackpot to nearby players, while the main portion still goes to the player who triggered it. This technique may be particularly effective in environments where players are seated close to each other, enhancing the social experience of casino gaming.

### Benefits to Players:

Players benefit from the chance to win a portion of the jackpot even if they didn't directly trigger it, simply by being near the winning player. This technique adds a communal aspect to the gaming experience, making players feel connected to one another. It also enhances the excitement around jackpot events, as nearby players know they may still receive a reward. Additionally, the proximity reward incentivizes players to stay engaged and remain seated, as their chances of winning a portion of the jackpot increase if they are near an active player.

### Benefits to Casinos:

Casinos benefit by promoting longer play sessions and encouraging players to stay in their seats. The proximity reward creates a positive, communal atmosphere that enhances the social element of casino gaming. Players are more to feel involved and excited when a jackpot is triggered, even if they are not the direct winner. This technique also helps spread the excitement across the gaming floor, as multiple players share in the jackpot event, potentially increasing overall player satisfaction and retention.

### Example Walk-Through Scenario:

In a live dealer blackjack game at an LDGT, Player 1 triggers a $12,000 jackpot by hitting a rare card combination. The system checks the seating arrangement and determines that Players 2 and 3 are seated next to Player 1, within the designated proximity range. While Player 1 receives 80% of the jackpot, or $9,600, Players 2 and 3 each receive 10%, or $1,200, as part of the proximity reward.

This walk-through demonstrates how the Jackpot Proximity Reward technique creates a sense of shared excitement among nearby players, ensuring that multiple participants benefit from the jackpot event.

### Example System Procedural Flow:

Tracking Seating Arrangements: The system continuously monitors the seating positions of all players, logging their proximity to one another.

Identifying Nearby Players: When the jackpot event is triggered, the system identifies which players are within the predefined proximity range of the jackpot winner.

Jackpot Distribution: The system allocates a portion of the jackpot to the nearby players while awarding the main portion to the player who triggered the jackpot.

Payout Process: The system displays the payout for the jackpot winner and nearby players, showing how the proximity reward is distributed.

Logging and Auditing: All seating data, proximity calculations, and jackpot payouts are logged for auditing and compliance within the casino's central network.

### Noteworthy Aspects and Features:

Fosters a Social Environment: The proximity reward encourages a communal atmosphere, where nearby players share in the excitement of the jackpot.

Encourages Longer Sessions: Players are more to stay in their seats, knowing they may receive a reward if someone nearby wins.

Increases Engagement: The technique keeps all players engaged, as they feel involved in the outcome even if they are not the direct winner.

Simple Implementation: The system tracks proximity automatically, making the jackpot distribution process easy to manage.

### Mystery Jackpot Distribution Technique #31—Jackpot Multiplier for High-Rollers

### Description and Implementation:

The Jackpot Multiplier for High-Rollers technique rewards players who place larger bets by applying a multiplier to their share of the jackpot when it is triggered. High-rollers, or players who consistently place large wagers, receive a larger percentage of the jackpot compared to lower-stakes players. This multiplier may vary based on the bet size, with higher bet thresholds unlocking progressively larger multipliers.

In an ETGT or LDGT environment, the system tracks each player's bet sizes and assigns multipliers accordingly. When the jackpot event occurs, the system calculates the payout for each player, applying a higher multiplier to those who have placed larger bets. This technique rewards risk-taking behavior and encourages players to increase their wager amounts for a chance at a bigger jackpot payout.

### Benefits to Players:

Players benefit from this technique by having their riskier, larger bets rewarded with a higher potential payout. High-rollers are incentivized to continue placing larger wagers, knowing that their share of the jackpot will be significantly boosted if they trigger the event. This technique adds excitement and strategy to the game, as players may choose to increase their bets to unlock higher multipliers. It also appeals to competitive players who enjoy the challenge of high-stakes gaming.

### Benefits to Casinos:

For casinos, the Jackpot Multiplier for High-Rollers technique encourages larger bets, driving higher overall wager volumes and increasing the jackpot pool more quickly. The promise of a higher multiplier motivates players to raise their bet sizes, leading to increased revenue for the casino. Additionally, the technique appeals to high-rollers and competitive players, helping to attract a broader range of players to the game and enhancing the overall gaming experience.

### Example Walk-Through Scenario:

In a live dealer baccarat game at an ETGT, five players are contributing to the jackpot pool. Player 1 consistently places bets of $500 per round, while Player 2 bets $200, and Players 3, 4, and 5 place smaller bets ranging from $50 to $100.

When the jackpot event is triggered, the system applies a 2× multiplier to Player 1's share due to their high-stakes betting. As a result, Player 1 receives 40% of the $20,000 jackpot, earning $8,000. Player 2, with a smaller multiplier, receives 25%, or $5,000, while the remaining players split the remaining $7,000 based on their lower bet sizes and multipliers.

This walk-through demonstrates how the Jackpot Multiplier for High-Rollers rewards players who place larger bets, encouraging them to increase their stakes for a higher potential payout.

### Example System Procedural Flow:

Tracking Bet Sizes: The system monitors each player's bet sizes throughout the session, assigning multipliers based on the size of the wagers.

Multiplier Assignment: The system calculates the appropriate multiplier for each player, with larger bets receiving higher multipliers.

Jackpot Trigger: When the jackpot event occurs, the system applies the multipliers to each player's share of the jackpot, increasing the payout for high-stakes players.

Payout Process: The system displays the payout for each player, highlighting the effect of the multiplier on the final jackpot distribution.

Logging and Auditing: All bet data, multiplier calculations, and jackpot payouts are logged for auditing and compliance within the casino's central network.

### Noteworthy Aspects and Features:

Rewards High-Stakes Betting: Players are incentivized to place larger bets, knowing that they will receive a higher jackpot payout if they trigger the event.

Increases Betting Volume: The multiplier system encourages larger wagers, leading to higher overall revenue for the casino.

Appeals to High-Rollers: The technique caters to competitive, high-stakes players who enjoy the challenge and rewards of betting big.

Dynamic Payouts: The use of multipliers adds excitement to the jackpot distribution, as players may increase their potential winnings by taking bigger risks.

### Mystery Jackpot Distribution Technique #32—Performance-Based Jackpot Share

### Description and Implementation:

The Performance-Based Jackpot Share technique distributes the jackpot based on the individual performance of each player during the session. This method rewards players who demonstrate superior in-game performance, such as winning the most hands in a card game or making the most successful bets in a roulette session. The system tracks various performance metrics and allocates larger portions of the jackpot to players who perform better.

In an ETGT or LDGT environment, the system monitors each player's actions throughout the session, tracking notable performance indicators such as hands won, bets placed, and strategic decisions. When the jackpot event is triggered, the system calculates the jackpot distribution based on these metrics, with higher-performing players receiving a larger share of the jackpot.

### Benefits to Players:

Players benefit from this technique by being rewarded for their skill and performance rather than relying solely on luck. High-performing players are incentivized to continue playing strategically, knowing that their superior performance will lead to a larger share of the jackpot. This technique appeals to players who enjoy skill-based gaming, as it provides a direct reward for mastering the game. It also encourages friendly competition among players, as they strive to outperform each other for a bigger payout.

### Benefits to Casinos:

For casinos, the Performance-Based Jackpot Share technique drives player engagement and longer play sessions, as players are motivated to improve their performance in pursuit of a larger jackpot share. The technique encourages strategic and skillful play, attracting players who enjoy games that reward skill over chance. Additionally, the system may be customized to track a variety of performance metrics, allowing casinos to tailor the jackpot distribution to the specific dynamics of the game being played.

### Example Walk-Through Scenario:

In a live dealer poker game at an ETGT, five players are competing for a share of the jackpot. Player 1 consistently wins the most hands, demonstrating strong strategic play, while Player 2 places the largest bets and wins several notable rounds. Players 3, 4, and 5 contribute to the game but perform less consistently.

When the jackpot event is triggered, the system reviews each player's performance metrics. Player 1, having won the most hands, receives 50% of the $10,000 jackpot, earning $5,000. Player 2, who placed the largest bets and won notable rounds, receives 30%, or $3,000. Players 3, 4, and 5 split the remaining $2,000 based on their performance.

This walk-through shows how the Performance-Based Jackpot Share technique rewards players for their skill and strategic decisions, encouraging competitive play and strategic thinking.

### Example System Procedural Flow:

Tracking Performance Metrics: The system monitors each player's in-game performance, tracking metrics such as hands won, bets placed, and strategic decisions.

Performance Evaluation: When the jackpot event is triggered, the system evaluates each player's performance and calculates their share of the jackpot based on these metrics.

Jackpot Distribution: The system allocates larger portions of the jackpot to higher-performing players, while lower-performing players receive smaller shares.

Payout Process: The system displays the payout for each player, showing how their performance influenced their share of the jackpot.

Logging and Auditing: All performance data, jackpot calculations, and payouts are logged for auditing and compliance within the casino's central network.

### Noteworthy Aspects and Features:

Rewards Skillful Play: Players are incentivized to play strategically, as superior performance leads to a larger share of the jackpot.

Competitive Atmosphere: The technique encourages friendly competition among players, driving engagement and excitement.

Flexible Metrics: Casinos may track a variety of performance metrics, allowing the system to be tailored to different game types.

Engages Skilled Players: The focus on performance appeals to players who enjoy skill-based gaming, attracting a broader range of participants.

### Mystery Jackpot Distribution Technique #33—Jackpot for Consecutive Wins

### Description and Implementation:

The Jackpot for Consecutive Wins technique rewards players who achieve a specific number of consecutive wins during the game session. Players who maintain a winning streak are allocated a larger portion of the jackpot when it is triggered, with the size of the reward increasing as the streak lengthens. This technique emphasizes consistent success and encourages players to focus on achieving multiple wins in a row.

In an ETGT or LDGT environment, the system tracks each player's win streaks, logging how many consecutive rounds or hands they win. When the jackpot event is triggered, players who have achieved the required number of consecutive wins are awarded larger shares of the jackpot. The system may also offer bonus rewards for exceptionally long streaks, further incentivizing players to strive for consecutive wins.

### Benefits to Players:

Players benefit from this technique by being rewarded for maintaining a winning streak, adding an extra challenge to their gameplay. The focus on consecutive wins provides a clear and achievable goal for players, motivating them to play more strategically and consistently. The potential for bonus rewards on longer streaks adds excitement to the game, encouraging players to stay engaged and push for more consecutive wins. This technique appeals to competitive players who enjoy the challenge of achieving a streak and are motivated by tangible rewards.

### Benefits to Casinos:

For casinos, the Jackpot for Consecutive Wins technique encourages longer play sessions and higher player engagement, as players strive to achieve and maintain winning streaks. The technique promotes strategic and consistent play, leading to higher betting activity and increased wager volumes. Additionally, the system may be customized to set the difficulty of the streaks required, allowing casinos to control the frequency and size of jackpot payouts based on player performance.

### Example Walk-Through Scenario:

In a live dealer roulette game at an ETGT, Player 1 wins three consecutive spins by betting on specific numbers, while Player 2 wins two consecutive rounds by betting on red/black. Players 3, 4, and 5 do not achieve consecutive wins during the session.

When the jackpot event is triggered, the system reviews each player's win streaks. Player 1, with the longest streak, receives 50% of the $8,000 jackpot, earning $4,000. Player 2, with a shorter streak, receives 30%, or $2,400. The remaining $1,600 is distributed among Players 3, 4, and 5 based on their general betting contributions.

This walk-through demonstrates how the Jackpot for Consecutive Wins technique rewards players who achieve and maintain winning streaks, creating a sense of accomplishment and excitement.

### Example System Procedural Flow:

Tracking Win Streaks: The system monitors each player's win streaks, logging how many consecutive rounds or hands they win.

Evaluating Streaks: When the jackpot event is triggered, the system evaluates each player's streak length and determines their share of the jackpot accordingly.

Jackpot Distribution: Players with longer win streaks receive larger portions of the jackpot, while those with shorter or no streaks receive smaller shares.

Payout Process: The system displays the payout for each player, highlighting the impact of their win streak on their jackpot share.

Logging and Auditing: All win streak data, jackpot calculations, and payouts are logged for auditing and compliance within the casino's central network.

### Noteworthy Aspects and Features:

Rewards Consistency: Players are incentivized to maintain winning streaks, encouraging strategic and consistent play.

Clear Goal for Players: The focus on consecutive wins provides players with a clear and achievable goal to strive for.

Excitement and Engagement: The potential for larger rewards with longer streaks keeps players engaged and motivated throughout the game.

Customizable Difficulty: Casinos may adjust the difficulty of the required streaks, allowing them to control jackpot payouts and player challenges.

### Mystery Jackpot Distribution Technique #34—Jackpot Share for Side Bet Participation

### Description and Implementation:

The Jackpot Share for Side Bet Participation technique rewards players who actively engage in side bets during the game by giving them a larger share of the jackpot when it is triggered. In this method, players must place side bets, which are additional wagers separate from the main game, to qualify for the jackpot. These side bets often come with higher risks and different odds but also present opportunities for players to increase their potential payout.

In an ETGT or LDGT environment, the system tracks which players opt into side bets during each round. When the jackpot event occurs, the system allocates a portion of the jackpot to players based on their side bet activity. Those who place side bets regularly receive a larger share, while players who stick to the main game receive smaller portions or none at all. This technique incentivizes players to take on more risk by participating in side bets.

### Benefits to Players:

Players benefit from the potential to win larger portions of the jackpot by participating in side bets. This technique introduces more excitement and engagement, as side bets often offer different outcomes and odds compared to the main game. For players who enjoy taking calculated risks, side bet participation adds a new layer of strategy and reward to the game. Additionally, players who feel their chances of winning the main game are slim may find value in placing side bets, knowing that these wagers may still qualify them for a jackpot share.

### Benefits to Casinos:

For casinos, the Jackpot Share for Side Bet Participation technique encourages players to make additional wagers, increasing overall betting activity and revenue. By promoting side bet participation, casinos may enhance the gaming experience with more dynamic and varied betting options. This method also helps casinos manage their jackpot payouts more effectively, as it limits the number of players who qualify for the jackpot, making the rewards more exclusive and motivating players to engage in more diverse betting strategies.

### Example Walk-Through Scenario:

In a live dealer baccarat game at an ETGT, five players are participating. Players 1, 2, and 3 consistently place side bets on outcomes like “Player Pair” or “Tie,” while Players 4 and 5 only focus on the main game. When the jackpot event is triggered, the system allocates a larger share of the $10,000 jackpot to those who participated in side bets.

Player 1, who placed side bets in every round, receives 50% of the jackpot, earning $5,000. Player 2, who placed side bets in half the rounds, receives 30%, or $3,000, while Player 3 receives 20%, or $2,000. Players 4 and 5, who did not place side bets, do not receive any portion of the jackpot, highlighting how side bet participation directly impacts jackpot eligibility.

### Example System Procedural Flow:

Tracking Side Bets: The system monitors each player's participation in side bets during every round, logging their wager amounts and outcomes.

Identifying Eligible Players: When the jackpot event is triggered, the system identifies players who placed side bets and are therefore eligible for a share of the jackpot.

Jackpot Allocation: The system allocates a larger share of the jackpot to players based on the frequency and size of their side bets, with those who participated more frequently receiving larger portions.

Payout Process: Players who placed side bets receive their portion of the jackpot, while players who did not participate in side bets are excluded from the payout. The results are displayed on each player's terminal.

Logging and Auditing: The system logs all side bet activity, jackpot eligibility, and payout details for auditing and compliance purposes within the casino's central network.

### Noteworthy Aspects and Features:

Encourages Risk-Taking: Players are incentivized to take on additional risks by participating in side bets, knowing that doing so increases their chances of winning a larger share of the jackpot.

Increases Betting Volume: The technique boosts overall betting activity by promoting side bets as a means to qualify for jackpot participation.

Differentiated Payouts: The method creates a tiered payout structure, rewarding players who diversify their betting strategies with larger jackpot shares.

Flexible Integration: The system may be customized to apply to various side bet options, making it adaptable to different games and player preferences.

### Mystery Jackpot Distribution Technique #35—Team-Based Jackpot Distribution

### Description and Implementation:

The Team-Based Jackpot Distribution technique introduces a cooperative element by dividing the jackpot among teams of players who collectively work toward achieving specific goals or milestones in the game. Players are grouped into teams, either by random assignment or by their choice, and the jackpot is distributed based on the performance of the team as a whole rather than individual accomplishments. This technique adds a social and collaborative aspect to the game, where players must work together to maximize their chances of winning.

In an ETGT or LDGT environment, the system monitors the performance of each team and allocates the jackpot accordingly. Team performance metrics may include collective wins, total bets placed, or the achievement of in-game objectives. When the jackpot is triggered, the winning team receives the jackpot, which is then divided equally or based on individual contributions to the team's success.

### Benefits to Players:

Players benefit from the Team-Based Jackpot Distribution technique by gaining the opportunity to collaborate with other players, which may make the gaming experience more enjoyable and social. Working together as a team to achieve shared goals introduces a new level of strategy, where players must consider how their individual actions affect the team's overall performance. For players who enjoy social interaction, this method fosters a sense of camaraderie and shared victory. Additionally, players who may struggle individually may still win a share of the jackpot by contributing to the team's success.

### Benefits to Casinos:

For casinos, this technique enhances player engagement by encouraging teamwork and cooperation. Players are more to stay in the game longer, as they rely on their teammates to help secure a portion of the jackpot. The team-based approach also increases betting volume, as players work together to meet performance metrics that qualify them for a jackpot payout. This method appeals to social players and groups of friends who prefer cooperative gaming experiences, making it a valuable tool for retaining and attracting players.

### Example Walk-Through Scenario:

In a live dealer roulette game at an ETGT, five players are divided into two teams: Team A (Players 1, 2, and 3) and Team B (Players 4 and 5). The system tracks each team's total bets and the number of rounds won. Team A consistently places larger bets and wins more rounds than Team B.

When the jackpot event is triggered, Team A qualifies for the $15,000 jackpot. The system divides the jackpot equally among the team members, with Players 1, 2, and 3 each receiving $5,000. Team B, despite contributing to the game, does not qualify for the jackpot because their performance metrics were lower.

This walk-through shows how the Team-Based Jackpot Distribution technique promotes teamwork and rewards players for collaborating to achieve in-game objectives.

### Example System Procedural Flow:

Team Formation: The system assigns players to teams either randomly or based on player choice, tracking each team's performance metrics throughout the game session.

Tracking Team Performance: The system monitors each team's collective performance, including metrics like total bets placed, rounds won, and in-game achievements.

Jackpot Trigger: When the jackpot event is triggered, the system identifies the winning team based on their performance and allocates the jackpot to the team.

Team Payout Process: The system distributes the jackpot to the winning team members, either equally or based on individual contributions to the team's success. The results are displayed on each player's terminal.

Logging and Auditing: All team performance data, jackpot allocation, and payout details are logged in the casino's central system for auditing and compliance purposes.

### Noteworthy Aspects and Features:

Fosters Cooperation: The team-based approach encourages players to collaborate and work together to achieve shared goals, adding a social element to the game.

Encourages Engagement: Players are more to stay engaged and bet actively when they rely on teammates to help secure a jackpot win.

Appeals to Social Players: This method is particularly attractive to groups of friends or players who enjoy cooperative gaming experiences.

Customizable Metrics: The system may track a wide range of performance metrics, allowing casinos to tailor the team-based competition to different game types and player preferences.

### Mystery Jackpot Distribution Technique #36—Jackpot Boost for Late Entries

### Description and Implementation:

The Jackpot Boost for Late Entries technique rewards players who join the game later in the session by giving them a boosted share of the jackpot when it is triggered. This technique introduces a catch-up mechanism, allowing players who did not participate from the start to still qualify for a significant portion of the jackpot. The system calculates a bonus multiplier for late corners based on the timing of their entry and the amount they bet after joining the game.

In an ETGT or LDGT setting, the system tracks when each player joins the game and applies a boost to their jackpot share if they join after a certain point in the session. This boost compensates for their shorter time in the game, encouraging more players to enter even if they missed the early rounds. The technique adds excitement for late entries while still maintaining fairness for early participants.

### Benefits to Players:

Players benefit from this technique by being incentivized to join the game even if they are late, knowing that they still have a chance to win a boosted portion of the jackpot. This method levels the playing field for late corners, making them feel more involved in the game and giving them a reason to participate. For players who may not have been able to join at the start, the Jackpot Boost for Late Entries ensures they aren't at a complete disadvantage, adding excitement and anticipation for those who arrive later.

### Benefits to Casinos:

For casinos, the Jackpot Boost for Late Entries technique drives higher participation by encouraging players to join ongoing games. By offering a bonus for late corners, casinos may keep tables full and maintain higher betting volumes throughout the entire session. This technique also helps reduce drop-off rates, as players who arrive late are still motivated to place bets in pursuit of a jackpot share. The boost mechanism also adds a dynamic element to the game, keeping it exciting for all players, regardless of when they enter.

### Example Walk-Through Scenario:

In a live dealer blackjack game at an ETGT, five players are participating. Players 1, 2, and 3 joined at the start of the session, while Players 4 and 5 joined later. The system tracks when Players 4 and 5 entered the game and applies a 1.5× boost to their potential jackpot share due to their late entry.

When the jackpot event is triggered, the system allocates 50% of the $12,000 jackpot to Players 1, 2, and 3, who receive $2,000 each. Players 4 and 5, due to their late entry and the applied boost, receive 25% each, earning $3,000 each despite having played fewer rounds.

This walk-through shows how the Jackpot Boost for Late Entries technique rewards late corners while maintaining a fair distribution of the jackpot for early participants.

### Example System Procedural Flow:

Tracking Player Entries: The system monitors when each player joins the game, logging their entry time and calculating any applicable boost based on their timing.

Boost Application: The system applies a boost to the jackpot share for players who join after a certain point in the session, compensating for their shorter time in the game.

Jackpot Trigger: When the jackpot event is triggered, the system calculates each player's share of the jackpot, applying the boost to latecomers to increase their portion.

Payout Process: The system distributes the jackpot to all eligible players, displaying the boosted amounts for late entries and the base amounts for early participants.

Logging and Auditing: All player entry data, boost calculations, and jackpot payouts are logged in the casino's central system for auditing and compliance purposes.

### Noteworthy Aspects and Features:

Encourages Late Participation: Players who join the game later are incentivized to participate, knowing that they still have a chance to win a boosted jackpot share.

Keeps Tables Full: By offering a boost for latecomers, casinos may maintain higher participation levels and betting volumes throughout the session.

Fairness and Excitement: The boost mechanism balances the game for latecomers while still rewarding early participants, keeping the game fair and exciting.

Dynamic Payouts: The technique adds a dynamic element to jackpot distribution, making the outcome more unpredictable and engaging for all players.

### Mystery Jackpot Distribution Technique #37—Accumulative Play Time Bonus

### Description and Implementation:

The Accumulative Play Time Bonus technique distributes a portion of the jackpot based on how long each player has been actively participating in the game. The longer a player remains engaged, the larger their potential share of the jackpot becomes. This method rewards players for staying in the game and placing consistent bets over a longer period, encouraging longer play sessions and sustained engagement.

In an ETGT or LDGT environment, the system tracks the amount of time each player spends actively participating in the game. When the jackpot event is triggered, players who have been playing for longer receive a larger portion of the jackpot. The system may apply time-based multipliers or bonuses to increase the payout for players who have accumulated significant play time.

### Benefits to Players:

Players benefit from this technique by being rewarded for their dedication and time spent in the game. The longer they stay engaged, the more they stand to gain when the jackpot is triggered. This technique appeals to players who enjoy extended gaming sessions and provides an incentive to remain active even during slower rounds. It also adds a sense of progression, as players may see their potential jackpot share grow with each passing minute of play.

### Benefits to Casinos:

For casinos, the Accumulative Play Time Bonus technique encourages longer play sessions, which leads to increased overall betting volume and revenue. Players are motivated to stay in the game for extended periods, knowing that their time spent playing directly impacts their potential jackpot payout. This technique also helps reduce player churn, as it rewards consistent participation and discourages players from leaving the table prematurely.

### Example Walk-Through Scenario:

In a live dealer roulette game at an ETGT, Player 1 has been playing for 90 minutes, Player 2 for 60 minutes, Player 3 for 45 minutes, and Players 4 and 5 for 30 minutes each. When the jackpot event is triggered, the system calculates each player's share based on their play time.

Player 1, having played the longest, receives 40% of the $10,000 jackpot, earning $4,000. Player 2, with 60 minutes of play, receives 30%, or $3,000. Player 3 receives 20%, or $2,000, while Players 4 and 5 each receive $500 for their shorter participation time.

This walk-through demonstrates how the Accumulative Play Time Bonus technique rewards players for their time spent in the game, encouraging them to stay engaged for longer periods.

### Example System Procedural Flow:

Tracking Play Time: The system monitors how long each player has been actively participating in the game, logging their play time throughout the session.

Applying Time Bonuses: The system applies time-based multipliers or bonuses to increase the jackpot share for players who have accumulated longer play time.

Jackpot Trigger: When the jackpot event is triggered, the system calculates each player's share of the jackpot based on their total play time.

Payout Process: Players with longer play times receive larger portions of the jackpot, while those with shorter play times receive smaller shares.

Logging and Auditing: All play time data, bonus calculations, and jackpot payouts are logged in the casino's central system for auditing and compliance purposes.

### Noteworthy Aspects and Features:

Rewards Long Sessions: Players are incentivized to remain engaged in the game for longer periods, knowing that their play time directly affects their jackpot share.

Increases Player Retention: The technique encourages players to stay in the game, reducing chum and increasing overall participation.

Fair and Engaging: The longer a player participates, the greater their reward, making the game fair for all players while promoting longer sessions.

Dynamic Reward System: The time-based bonus adds a dynamic element to the jackpot distribution, rewarding players for their consistent participation.

### Mystery Jackpot Distribution Technique #38—Jackpot Share for Specific Game Outcomes

### Description and Implementation:

The Jackpot Share for Specific Game Outcomes technique distributes portions of the jackpot to players who achieve particular game outcomes or meet predefined conditions during gameplay. These outcomes may be rare events like winning with a specific hand in blackjack, hitting a straight flush in poker, or landing on a specific combination in roulette. The system tracks these specific outcomes throughout the session, and when the jackpot is triggered, players who have met these conditions receive a larger portion of the jackpot.

In an ETGT or LDGT environment, the system monitors player actions and identifies when a player hits a designated outcome. These predefined outcomes are typically harder to achieve, creating excitement and offering higher rewards. Players who meet one or more of these conditions are eligible for a higher jackpot share than those who did not meet any special outcomes.

### Benefits to Players:

Players benefit from the opportunity to win larger jackpot shares by achieving specific in-game outcomes, adding an extra layer of excitement and challenge. The potential for bigger rewards creates an incentive to play more strategically and aim for these rare events. Even if a player doesn't win the main game, they may still qualify for a significant jackpot payout by meeting one of the predefined conditions. This technique appeals to players who enjoy chasing rare achievements and adds variety to the game.

### Benefits to Casinos:

For casinos, this technique drives higher engagement as players work toward hitting specific outcomes that qualify them for a larger jackpot share. The focus on predefined, difficult-to-achieve events keeps players invested in the game, as they know that achieving these outcomes will lead to substantial rewards. Casinos may also control the distribution of jackpots more effectively by defining outcomes that are challenging but attainable, ensuring that payouts are significant but not too frequent.

### Example Walk-Through Scenario:

In a live dealer poker game at an ETGT, the system tracks specific outcomes such as hitting a royal flush, winning with a pair of aces, or winning three consecutive hands. Players 1 and 2 each hit a royal flush during different rounds, while Player 3 wins three consecutive hands. Players 4 and 5 participate but do not achieve any special outcomes.

When the jackpot event is triggered, the system allocates larger shares of the $15,000 jackpot to Players 1, 2, and 3 based on their specific outcomes. Players 1 and 2 each receive $5,000 for hitting royal flushes, while Player 3 receives $3,000 for winning three consecutive hands. Players 4 and 5, who did not meet any special conditions, split the remaining $2,000.

This walk-through demonstrates how the Jackpot Share for Specific Game Outcomes technique rewards players who achieve rare or challenging outcomes, creating excitement and higher payouts.

### Example System Procedural Flow:

Tracking Game Outcomes: The system monitors each player's actions during gameplay, identifying when they hit specific predefined outcomes like rare hands or special combinations.

Eligibility Determination: When the jackpot event is triggered, the system determines which players met the required outcomes and are eligible for a larger jackpot share.

Jackpot Allocation: The system allocates a larger portion of the jackpot to players who achieved the specific outcomes, while the remaining amount is distributed to other players.

Payout Process: The system displays the payout results on each player's terminal, showing how their specific outcomes influenced their share of the jackpot.

Logging and Auditing: All game outcome data, jackpot allocation, and payout details are logged in the casino's central system for auditing and compliance purposes.

### Noteworthy Aspects and Features:

Encourages Strategic Play: Players are incentivized to aim for specific outcomes, adding a layer of strategy and excitement to the game.

Higher Engagement: Players remain more engaged as they work toward achieving predefined, rare outcomes that may lead to bigger rewards.

Flexible Integration: Casinos may easily adjust the specific outcomes required to qualify for larger jackpot shares, tailoring the experience to different games.

Dynamic Rewards: The focus on specific outcomes creates a dynamic and exciting jackpot distribution system that keeps players invested in the game.

### Mystery Jackpot Distribution Technique #39—Jackpot for Game Round Milestones

### Description and Implementation:

The Jackpot for Game Round Milestones technique allocates portions of the jackpot to players based on the number of rounds or hands they have participated in during the session. Players who reach specific milestones, such as playing 50 or 100 rounds, qualify for a share of the jackpot, with higher milestone achievements leading to larger shares. This technique rewards players for their commitment and consistency over the course of a gaming session.

In an ETGT or LDGT setting, the system tracks each player's participation in game rounds, logging their progress toward predefined milestones. When the jackpot event is triggered, the system allocates shares of the jackpot based on how many rounds or hands each player has completed. The more rounds a player has participated in, the larger their share of the jackpot, encouraging longer play sessions.

### Benefits to Players:

Players benefit from the Jackpot for Game Round Milestones technique by being rewarded for their persistence and commitment to the game. This method provides a clear, attainable goal for players who may not be winning every round but want to earn a portion of the jackpot. The technique also appeals to players who enjoy long gaming sessions, as it incentivizes them to stay in the game longer to reach higher milestones and qualify for larger rewards.

### Benefits to Casinos:

For casinos, this technique increases player retention and betting volume, as players are motivated to continue playing in pursuit of reaching specific game milestones. By rewarding players for their long-term participation, casinos may encourage extended sessions and higher wager totals. The system may also be customized to set appropriate milestone thresholds based on game type, ensuring that the jackpot distribution remains balanced and exciting.

### Example Walk-Through Scenario:

In a live dealer roulette game at an ETGT, the system tracks each player's progress toward game round milestones. Players 1, 2, and 3 have played 100 rounds, while Players 4 and 5 have played 50 rounds. When the jackpot event is triggered, the system allocates the $10,000 jackpot based on these milestones.

Players 1, 2, and 3, having reached the highest milestone of 100 rounds, each receive 30% of the jackpot, earning $3,000 each. Players 4 and 5, having reached the 50-round milestone, split the remaining $1,000, receiving $500 each.

This walk-through shows how the Jackpot for Game Round Milestones technique rewards players for their dedication and long-term participation in the game, encouraging them to stay engaged.

### Example System Procedural Flow:

Tracking Game Rounds: The system monitors how many rounds or hands each player participates in, logging their progress toward predefined milestones.

Milestone Achievement: The system identifies players who have reached specific game round milestones and qualifies them for a larger share of the jackpot.

Jackpot Trigger: When the jackpot event is triggered, the system calculates each player's share based on their milestone achievements.

Payout Process: Players who reached higher milestones receive larger portions of the jackpot, while those who reached lower milestones receive smaller shares.

Logging and Auditing: All game round data, milestone achievements, and jackpot payouts are logged in the casino's central system for auditing and compliance purposes.

### Noteworthy Aspects and Features:

Rewards Long-Term Participation: Players are incentivized to stay in the game longer, knowing that their participation contributes to a larger jackpot share.

Encourages Longer Sessions: The technique promotes extended play, leading to higher overall betting volumes for casinos.

Fair and Attainable Goals: Players of all skill levels may qualify for jackpot rewards by simply participating in enough rounds, making the system fair and engaging.

Flexible Milestone Setting: Casinos may adjust milestone thresholds to suit different game types, ensuring that the jackpot distribution remains exciting and balanced.

### Mystery Jackpot Distribution Technique #40-Jackpot Share for Betting Patterns

### Description and Implementation:

The Jackpot Share for Betting Patterns technique allocates portions of the jackpot based on specific betting behaviors or patterns exhibited by players during the game session. Players who follow certain betting patterns, such as alternating between high and low bets, placing bets on consecutive numbers, or betting on a particular color for multiple rounds, qualify for a share of the jackpot. This technique introduces an additional layer of strategy, as players are rewarded for how they place their bets, not just the outcomes of those bets.

In an ETGT or LDGT environment, the system monitors the betting patterns of each player and identifies those who meet the predefined criteria. When the jackpot is triggered, players who followed the specified betting patterns are eligible for a larger share of the jackpot. This method encourages players to think more strategically about how they place their bets, adding complexity and excitement to the game.

### Benefits to Players:

Players benefit from this technique by being rewarded for their strategic betting behaviors, not just their winnings. This method appeals to players who enjoy experimenting with different betting patterns and strategies, as it provides them with a new way to qualify for a jackpot payout. The technique also adds variety to the game, allowing players to switch up their betting habits in pursuit of larger rewards. Even if a player doesn't win individual rounds, they may still qualify for a share of the jackpot by adhering to the required betting patterns.

### Benefits to Casinos:

For casinos, the Jackpot Share for Betting Patterns technique encourages more varied and strategic betting activity, leading to higher overall wager volumes. By promoting specific betting patterns, casinos may add an extra layer of complexity to the game, keeping players engaged and encouraging them to try different strategies. This

### Mystery Jackpot Distribution Technique #41—Jackpot Share for Lowest Bet Wins

### Description and Implementation:

The Jackpot Share for Lowest Bet Wins technique rewards players who win rounds or hands while placing the lowest possible bets. This distribution method contrasts with the common practice of rewarding players based on higher bets, offering an exciting alternative for low-stakes players. Players who win with the smallest bets throughout the session receive a larger share of the jackpot when it is triggered. This method levels the playing field, allowing low-stakes players to qualify for significant rewards based on their skill rather than the size of their wagers.

In an ETGT or LDGT environment, the system tracks each player's bet amounts and win history. When the jackpot event occurs, players who have won the most rounds with low bets receive a larger portion of the jackpot. The system ensures that these players are recognized for their success despite betting conservatively, offering a new way to reward tactical, low-risk play.

### Benefits to Players:

Players benefit from this technique by being able to win larger portions of the jackpot without having to place large bets. This method appeals to cautious or low-stakes players who prefer to bet conservatively but still want the chance to win big. It also introduces an element of strategy, where players may focus on making the most of their smaller bets. The technique makes the game more inclusive, as players with varying budgets may still participate in the jackpot system and receive substantial rewards.

### Benefits to Casinos:

For casinos, the Jackpot Share for Lowest Bet Wins technique encourages participation from a wider range of players, including those who may not feel comfortable placing high-stakes bets. This method increases overall participation by creating opportunities for low-stakes players to qualify for large rewards. The system also diversifies the gaming experience, making it more attractive to both high-rollers and casual players. Casinos benefit from the longer, more consistent sessions that result from low-risk players staying engaged in pursuit of the jackpot.

### Example Walk-Through Scenario:

In a live dealer roulette game at an ETGT, Player 1 consistently places the minimum bet of $10 but manages to win three rounds with this low bet. Player 2, who also places small bets of $20, wins two rounds, while Players 3, 4, and 5 place higher bets of $100 or more but win fewer rounds.

When the jackpot event is triggered, the system rewards the players with the lowest bets and the most wins. Player 1, who placed the lowest bet and won the most rounds, receives 50% of the $10,000 jackpot, earning $5,000. Player 2, with slightly larger bets and fewer wins, receives 30%, or $3,000. The remaining 20%, or $2,000, is split between Players 3, 4, and 5, despite their higher betting amounts.

This walk-through demonstrates how the Jackpot Share for Lowest Bet Wins technique rewards conservative, low-risk play while still providing meaningful payouts to more aggressive players.

### Example System Procedural Flow:

Tracking Bet Sizes and Wins: The system monitors each player's bet size and records the outcomes of each round, focusing on players who win with the lowest bets.

Jackpot Trigger: When the jackpot event is triggered, the system identifies the players who placed the lowest bets and won the most rounds, calculating their share of the jackpot.

Jackpot Allocation: The system allocates the jackpot, with the largest portion going to the player with the lowest bet and the most wins. Smaller shares are distributed to others based on their bet size and win history.

Payout Process: Players are shown their jackpot share, with an emphasis on how their low-bet strategy contributed to their payout.

Logging and Auditing: The system logs all bet data, win histories, and jackpot distribution details in the casino's central system for auditing and compliance.

### Noteworthy Aspects and Features:

Inclusive for Low-Stakes Players: This technique makes the game accessible to players who prefer low-risk betting, ensuring they still have a chance at significant rewards.

Strategic Betting: Players are encouraged to focus on tactical, low-stakes play, knowing that their success with small bets may lead to larger jackpot shares.

Diversified Payouts: The system rewards players of all bet sizes, creating a balanced and engaging environment for a wide range of participants.

Increased Player Retention: The opportunity to win big with small bets encourages longer play sessions and sustained engagement from low-stakes players.

### Mystery Jackpot Distribution Technique #42—Jackpot Share for Game Variety Participation

### Description and Implementation:

The Jackpot Share for Game Variety Participation technique rewards players who participate in a wide variety of games during their session. Rather than focusing on a single game or betting strategy, this method encourages players to diversify their play across different games or game variations. Players who switch between different table games-such as blackjack, roulette, and poker-qualify for larger portions of the jackpot when it is triggered. This technique promotes versatility and exploration within the casino environment.

In an ETGT or LDGT environment, the system tracks each player's participation in various games throughout the session. When the jackpot event is triggered, players who have engaged with multiple game types receive a larger share of the jackpot, while those who stuck to a single game receive smaller portions. This method encourages players to try different games, increasing overall engagement and participation across the casino's gaming floor.

### Benefits to Players:

Players benefit from this technique by being incentivized to explore and enjoy a variety of games, which may enhance their overall gaming experience. Instead of feeling locked into a single game, players are rewarded for switching between different options, which adds excitement and variety to their session. This technique also appeals to players who enjoy mastering multiple games, as it rewards versatility and broad engagement rather than focusing solely on success in a single game.

### Benefits to Casinos:

For casinos, the Jackpot Share for Game Variety Participation technique increases overall participation and engagement across different games. By encouraging players to switch between various games, casinos may boost traffic and revenue in areas that may not see as much consistent play. This technique also keeps the gaming experience fresh and exciting for players, reducing the likelihood of boredom or fatigue from playing the same game for extended periods. Additionally, the system helps casinos promote underutilized games, enhancing the overall balance of game participation.

### Example Walk-Through Scenario:

In a live dealer environment at an ETGT, five players are participating in various games throughout their session. Player 1 switches between blackjack, roulette, and poker, while Players 2 and 3 participate in blackjack and roulette. Players 4 and 5 stick to a single game-baccarat-throughout the session.

When the jackpot event is triggered, the system reviews each player's participation in different games. Player 1, having engaged in three different game types, receives 40% of the $20,000 jackpot, earning $8,000. Players 2 and 3, who played two games, each receive 25%, or $5,000. Players 4 and 5, who only played baccarat, split the remaining 10%, each receiving $1,000.

This walk-through illustrates how the Jackpot Share for Game Variety Participation technique rewards players for exploring and engaging with multiple games, increasing overall participation and excitement.

### Example System Procedural Flow:

Tracking Game Participation: The system monitors which games each player participates in throughout the session, logging their engagement with different game types.

Variety Calculation: When the jackpot event is triggered, the system calculates each player's share of the jackpot based on the variety of games they participated in.

Jackpot Allocation: Players who participated in more game types receive larger portions of the jackpot, while those who played only one game receive smaller shares.

Payout Process: The system displays each player's jackpot share and explains how their participation in multiple games influenced their payout.

Logging and Auditing: All game participation data and jackpot distribution details are logged for auditing and compliance purposes in the casino's central system.

### Noteworthy Aspects and Features:

Encourages Game Exploration: Players are rewarded for trying different games, keeping the experience fresh and exciting.

Increases Casino Engagement: The technique boosts participation across multiple game types, driving more traffic to different parts of the gaming floor.

Reward for Versatility: Players who enjoy a variety of games are rewarded for their broad participation, promoting long-term engagement.

Balanced Participation: Casinos may use this method to promote games that may not receive as much attention, enhancing overall balance in game engagement.

### Mystery Jackpot Distribution Technique #43—Jackpot Share for Fastest Wins

### Description and Implementation:

The Jackpot Share for Fastest Wins technique rewards players who achieve the quickest wins during a session, emphasizing speed and efficiency in gameplay. Players who win rounds or hands more rapidly than others receive a larger portion of the jackpot when it is triggered. This method encourages fast, decisive play and adds a competitive time-based element to the game. The system tracks the time taken to win each round and uses this data to determine which players qualify for larger jackpot shares.

In an ETGT or LDGT environment, the system monitors the duration of each round or hand and records the speed of player wins. When the jackpot event is triggered, players who achieved the fastest wins are allocated a larger portion of the jackpot. This technique introduces an additional layer of excitement, as players are incentivized to make quick decisions and play efficiently.

### Benefits to Players:

Players benefit from this technique by being rewarded for quick, efficient play. The focus on fast wins creates an exciting and competitive atmosphere, where players strive to outpace one another to qualify

### Mystery Jackpot Distribution Technique #44—Jackpot Share for High Bet Consistency

### Description and Implementation:

The Jackpot Share for High Bet Consistency technique rewards players who consistently place high bets throughout their gaming session. Unlike jackpot systems that emphasize one-time large bets or sudden risky moves, this method focuses on players who maintain a steady pattern of higher-than-average wagers. The system tracks each player's betting behavior, and when the jackpot is triggered, players who maintained consistent high bet levels are awarded larger portions of the jackpot.

In an ETGT or LDGT environment, the system monitors each player's bets over multiple rounds and calculates the average bet size. Those who consistently place bets above a predefined threshold receive larger jackpot shares, while players who place lower or less consistent bets receive smaller portions. This technique incentivizes players to maintain a consistent betting strategy, rewarding discipline and sustained risk-taking over time.

### Benefits to Players:

Players benefit from this technique by being rewarded for their steady, high-stakes gameplay. It provides an opportunity for high-rollers and consistent bettors to earn significant jackpot payouts without needing to rely on sudden bursts of luck. This method appeals to players who prefer to take calculated risks and maintain a strong wagering presence throughout their session. Additionally, players who enjoy a strategic approach to betting may focus on consistency rather than extreme risk to qualify for larger rewards.

### Benefits to Casinos:

For casinos, the Jackpot Share for High Bet Consistency technique drives higher and more consistent betting activity, as players are incentivized to maintain high stakes throughout the session. This method encourages longer playtimes, as players stay committed to their betting patterns in hopes of qualifying for a larger jackpot share. The technique also creates a sense of reward for players who are willing to take sustained risks, appealing to high-rollers and boosting overall revenue through larger, steady wagers.

### Example Walk-Through Scenario:

In a live dealer baccarat game at an ETGT, Player 1 consistently places bets of $300 to $400 each round, while Player 2 maintains bets around

### Mystery Jackpot Distribution Technique #43—Jackpot Share for Fastest Wins

### Description and Implementation:

The Jackpot Share for Fastest Wins technique rewards players who achieve wins in the shortest amount of time during a game session. The system tracks how quickly players win rounds, focusing on those who make efficient, decisive plays. Players who consistently achieve fast wins, such as quick hands in blackjack or fast outcomes in roulette, qualify for a larger portion of the jackpot when it is triggered. This method emphasizes speed and skill, adding a competitive, time-based element to the gameplay.

In an ETGT or LDGT setting, the system monitors the time taken by players to achieve wins in each round. When the jackpot event is triggered, players who have achieved the fastest wins over the session are awarded a larger share of the jackpot. The technique encourages players to adopt quick decision-making strategies, enhancing the pace of the game.

### Benefits to Players:

Players benefit from this technique by being rewarded for their quick thinking and decisive actions. This method adds an extra layer of excitement for players who enjoy a faster-paced game, offering them the opportunity to win larger jackpot shares if they may consistently win quickly. It also appeals to competitive players who enjoy outpacing others at the table, turning the speed of play into a notable aspect of their strategy.

### Benefits to Casinos:

For casinos, the Jackpot Share for Fastest Wins technique encourages faster gameplay, which may increase the number of rounds played and overall wagering activity. This leads to higher revenue as players place more bets in a shorter time frame. The method also enhances the competitive atmosphere, keeping players engaged as they try to outpace one another. Casinos may use this approach to maintain a dynamic and high-energy gaming environment, appealing to players who enjoy quick and exciting gameplay.

### Example Walk-Through Scenario:

In a live dealer blackjack game at an ETGT, the system tracks the speed of each player's wins. Player 1 consistently wins hands within 30 seconds, while Players 2 and 3 take closer to a minute per hand. Players 4 and 5 win less frequently and take longer to decide on their moves.

When the jackpot event is triggered, Player 1, who consistently won the fastest, receives 50% of the $10,000 jackpot, earning $5,000. Players 2 and 3, with slightly slower wins, receive 30% and 20% of the jackpot, earning $3,000 and $2,000, respectively. Players 4 and 5, with slower and fewer wins, do not qualify for the jackpot.

This scenario shows how the Jackpot Share for Fastest Wins technique rewards players for their speed and efficiency in gameplay, adding a competitive edge to the session.

### Example System Procedural Flow:

Tracking Win Times: The system monitors the time it takes for each player to win rounds, logging the speed of each win throughout the session.

Identifying Fast Wins: When the jackpot event is triggered, the system evaluates which players achieved the fastest wins based on the time taken for each round.

Jackpot Distribution: The system allocates a larger share of the jackpot to players with the quickest wins, while slower players receive smaller portions or none at all.

Payout Process: The system displays each player's jackpot share, highlighting the role of their quick wins in determining the payout.

Logging and Auditing: All win times, jackpot calculations, and payout details are logged in the casino's central system for auditing and compliance purposes.

### Noteworthy Aspects and Features:

Incentivizes Quick Play: Players are encouraged to make fast decisions and play efficiently, increasing the pace of the game.

Competitive Atmosphere: The focus on speed adds a competitive element, appealing to players who enjoy fast-paced, high-energy games.

Increases Engagement: The technique keeps players engaged by rewarding quick thinking and decisive actions, leading to more dynamic gameplay.

Higher Wager Volume: Faster gameplay leads to more rounds being played, increasing overall betting activity and revenue for the casino.

### Mystery Jackpot Distribution Technique #44—Jackpot Share for High Bet Consistency

### Description and Implementation:

The Jackpot Share for High Bet Consistency technique rewards players who maintain consistently high bet levels throughout their session. Instead of focusing on one-time large bets, this method emphasizes players who demonstrate sustained high-stakes betting over multiple rounds. The system tracks each player's bet sizes and identifies those who maintain a high average bet across the session. When the jackpot is triggered, players with consistently high bets receive a larger portion of the jackpot.

In an ETGT or LDGT environment, the system monitors each player's bets over time and calculates the average wager per round. Players who consistently place bets above a certain threshold qualify for larger jackpot shares. This technique incentivizes sustained high-stakes betting, encouraging players to maintain their risk-taking behavior throughout the session.

### Benefits to Players:

Players benefit from this technique by being rewarded for their commitment to high-stakes betting over the long term. It provides an opportunity for players who prefer a steady, high-bet strategy to earn significant rewards without relying on sudden, risky moves. The technique also appeals to players who enjoy maintaining a disciplined betting approach, knowing that their consistent risk-taking will be rewarded with a larger jackpot share.

### Benefits to Casinos:

For casinos, the Jackpot Share for High Bet Consistency technique drives more stable and higher overall betting activity. Players are encouraged to maintain larger wagers throughout the session, increasing the total amount wagered over time. This method also promotes longer play sessions, as players aim to sustain their high-stakes strategy in pursuit of a larger jackpot payout. By rewarding consistent high betting, casinos may increase the average wager size and overall revenue.

### Example Walk-Through Scenario:

In a live dealer baccarat game at an ETGT, Player 1 consistently places bets between $300 and $500 per round, while Players 2 and 3 place smaller but consistent bets around $100 to $200. Players 4 and 5 vary their bets more dramatically, with occasional large bets but mostly smaller ones.

When the jackpot event is triggered, Player 1, who maintained the highest and most consistent bet sizes, receives 60% of the $20,000 jackpot, earning $12,000. Players 2 and 3, with slightly lower but still consistent bets, receive 25% and 15%, earning $5,000 and $3,000, respectively. Players 4 and 5, with more erratic betting patterns, do not qualify for the jackpot.

This walk-through demonstrates how the Jackpot Share for High Bet Consistency technique rewards players who maintain a steady, high-risk betting strategy throughout the session.

### Example System Procedural Flow:

Tracking Bet Sizes: The system monitors each player's bet sizes over time, calculating the average bet amount across multiple rounds.

Identifying Consistent High Bets: When the jackpot event is triggered, the system identifies players who maintained consistently high bets and calculates their jackpot share.

Jackpot Allocation: The system allocates larger portions of the jackpot to players with the highest and most consistent bets, while those with lower or less consistent bets receive smaller portions or none.

Payout Process: The system displays each player's payout, showing how their consistent betting behavior influenced their share of the jackpot.

Logging and Auditing: All bet data, consistency calculations, and jackpot distributions are logged in the casino's central system for auditing and compliance.

### Noteworthy Aspects and Features:

Rewards Consistent High-Stakes Betting: Players are incentivized to maintain steady, high bets throughout the session, rewarding consistent risk-taking.

Increases Average Bet Size: The technique drives higher average wager amounts, increasing overall betting volume and revenue for the casino.

Promotes Longer Sessions: Players are encouraged to remain engaged and maintain their betting strategy over the long term, leading to extended playtimes.

Appeals to High-Rollers: The method appeals to players who enjoy high-stakes gaming, providing them with a structured way to earn larger jackpot shares.

### Mystery Jackpot Distribution Technique #45—Jackpot Share for Bet Variety

### Description and Implementation:

The Jackpot Share for Bet Variety technique rewards players who consistently vary their betting strategies during the game session. This method encourages players to mix up their wagers by switching between different bet types, such as alternating between inside and outside bets in roulette or using different side bets in poker. Players who demonstrate a broad range of betting behaviors are allocated larger shares of the jackpot when it is triggered.

In an ETGT or LDGT environment, the system tracks the variety of bet types each player uses throughout the session. When the jackpot event occurs, players who placed diverse bets receive a larger portion of the jackpot. This technique encourages players to experiment with different betting strategies, adding variety and excitement to the gameplay.

### Benefits to Players:

Players benefit from this technique by being rewarded for exploring different betting strategies rather than sticking to a single, repetitive approach. It adds an element of strategy to the game, as players must think about how they may diversify their bets to qualify for a larger jackpot share. This method also keeps the gameplay dynamic and engaging, as players are encouraged to try new bet types in pursuit of bigger rewards.

### Benefits to Casinos:

For casinos, the Jackpot Share for Bet Variety technique encourages more diverse betting behavior, which may lead to increased wagering activity across different bet types. By promoting varied betting strategies, casinos may maintain player interest and prevent the game from becoming monotonous. The technique also helps distribute wagering activity more evenly across different types of bets, which may enhance the overall balance of the game and create a more dynamic gaming experience.

### Example Walk-Through Scenario:

In a live dealer roulette game at an ETGT, five players are participating. Player 1 frequently alternates between inside bets, outside bets, and corner bets, displaying a wide variety of betting strategies. Player 2 switches between even-money bets and column bets, while Players 3, 4, and 5 tend to stick to consistent bet types, such as placing only outside bets or focusing on specific numbers.

When the jackpot event is triggered, the system evaluates each player's bet variety. Player 1, having demonstrated the most diverse betting strategies, receives 40% of the $12,000 jackpot, earning $4,800. Player 2, with some variety in their betting, receives 30%, or $3,600. Players 3, 4, and 5, who stuck to less diverse bet types, split the remaining $3,600, each receiving $1,200.

This walk-through illustrates how the Jackpot Share for Bet Variety technique rewards players who explore and apply a broad range of betting strategies, enhancing engagement and creating excitement in the gameplay.

### Example System Procedural Flow:

Tracking Bet Types: The system monitors the types of bets each player places during the game session, logging the variety and frequency of different bet types.

Identifying Bet Variety: When the jackpot event is triggered, the system evaluates which players demonstrated the most diverse betting strategies and calculates their share of the jackpot.

Jackpot Allocation: Players with greater bet variety receive larger shares of the jackpot, while those with more consistent or repetitive betting patterns receive smaller portions.

Payout Process: The system displays each player's jackpot share and explains how their betting diversity influenced their payout.

Logging and Auditing: All bet data, variety calculations, and jackpot distributions are logged in the casino's central system for auditing and compliance purposes.

### Noteworthy Aspects and Features:

Encourages Strategic Experimentation: Players are incentivized to try new betting strategies and explore different bet types, adding depth to the gameplay.

Dynamic Gameplay: The technique keeps the game exciting by encouraging players to mix up their bets, preventing repetitive play patterns.

Increases Engagement: By rewarding bet variety, the system promotes more active and strategic participation, leading to longer and more engaged play sessions.

Balances Betting Across the Table: The technique helps casinos spread wagering activity across different bet types, creating a more balanced and dynamic gaming environment.

### Mystery Jackpot Distribution Technique #46—Jackpot Share for Player Interaction

### Description and Implementation:

The Jackpot Share for Player Interaction technique rewards players who engage in social interaction or collaboration during gameplay. This method encourages players to work together or communicate with one another to achieve specific in-game goals, with the jackpot share being allocated based on the level of interaction each player contributes. The system may track various forms of interaction, such as team-based achievements, shared goals, or communication through in-game chat features.

In an ETGT or LDGT environment, the system monitors player interactions and assigns scores based on the level and quality of engagement between players. When the jackpot event is triggered, those who demonstrated the most interaction or collaboration with others receive larger portions of the jackpot. This technique adds a social element to the game, encouraging teamwork and community-building among players.

### Benefits to Players:

Players benefit from this technique by being rewarded for their social engagement and collaboration with others. For players who enjoy interacting with others in a gaming environment, this method offers a fun and engaging way to increase their jackpot share. The technique fosters a sense of camaraderie and teamwork, making the gaming experience more enjoyable for those who prefer a social atmosphere. Players who communicate and collaborate effectively are more to be rewarded.

### Benefits to Casinos:

For casinos, the Jackpot Share for Player Interaction technique promotes a social, community-focused environment that may increase player retention and satisfaction. Players who feel a stronger connection to their fellow participants are more to stay engaged and return for future sessions. The technique also encourages longer playtimes, as players remain active and communicative in pursuit of larger rewards. Additionally, the system may foster a positive, lively atmosphere on the casino floor or online platform, enhancing the overall gaming experience.

### Example Walk-Through Scenario:

In a live dealer poker game at an ETGT, five players are participating. Players 1 and 2 frequently engage in conversation through the in-game chat, discussing strategies and making collaborative decisions. Player 3 also interacts with others but less frequently, while Players 4 and 5 remain quiet and focus solely on their individual play.

When the jackpot event is triggered, the system reviews the level of interaction between players. Player 1, who demonstrated the most interaction and collaboration, receives 50% of the $10,000 jackpot, earning $5,000. Player 2, with moderate interaction, receives 30%, or $3,000. Player 3, who participated somewhat, receives 15%, or $1,500. Players 4 and 5, who did not engage, split the remaining 5%, each receiving $250.

This walk-through shows how the Jackpot Share for Player Interaction technique rewards players for their social engagement and collaborative gameplay, encouraging a more community-oriented experience.

### Example System Procedural Flow:

Tracking Player Interaction: The system monitors in-game chat, collaboration, and teamwork between players, logging the frequency and quality of interactions.

Interaction Scoring: When the jackpot event is triggered, the system assigns scores to each player based on their level of interaction and communication with others.

Jackpot Allocation: Players with higher interaction scores receive larger shares of the jackpot, while those with less engagement receive smaller portions or none at all.

Payout Process: The system displays each player's payout, showing how their social interactions influenced their share of the jackpot.

Logging and Auditing: All interaction data, jackpot allocations, and payout details are logged in the casino's central system for auditing and compliance purposes.

### Noteworthy Aspects and Features:

Promotes Social Engagement: Players are rewarded for interacting with others, encouraging a more social and collaborative gaming experience.

Fosters Community Atmosphere: The technique helps create a sense of camaraderie among players, making the game more enjoyable and immersive.

Increases Player Retention: Players who feel connected to their fellow participants are more to stay engaged and return for future sessions.

Encourages Communication: By rewarding communication and collaboration, the technique enhances the overall atmosphere of the game, leading to longer and more dynamic play sessions.

### Mystery Jackpot Distribution Technique #47—Jackpot Share for Consecutive Bets

### Description and Implementation:

The Jackpot Share for Consecutive Bets technique rewards players who place consecutive bets without skipping rounds. The more consecutive bets a player makes, the larger their share of the jackpot when it is triggered. This method encourages players to remain actively engaged in every round, minimizing downtime and maximizing betting consistency. The system tracks each player's participation in consecutive rounds and uses this data to determine their jackpot eligibility.

In an ETGT or LDGT environment, the system monitors the sequence of bets each player places and calculates how many rounds they consecutively participated in. When the jackpot is triggered, players who have placed bets in the most consecutive rounds are rewarded with larger portions of the jackpot. This technique promotes consistent betting behavior and encourages players to stay fully engaged in the game.

### Benefits to Players:

Players benefit from this technique by being rewarded for their active and consistent participation in the game. The more rounds they consecutively bet on, the greater their potential jackpot share, giving them an incentive to remain engaged throughout the session. This technique appeals to players who prefer uninterrupted play and rewards those who are dedicated to placing bets every round. It also adds an element of strategy, as players must weigh the benefits of consistent betting versus taking breaks.

### Benefits to Casinos:

For casinos, the Jackpot Share for Consecutive Bets technique increases overall betting volume by encouraging players to remain actively engaged in every round. This method reduces downtime between bets, leading to more frequent wagering and higher revenue. The technique also promotes longer play sessions, as players are motivated to continue betting without interruption in order to maximize their jackpot share. By keeping players consistently engaged, casinos may increase the overall excitement and pace of the game.

### Example Walk-Through Scenario:

In a live dealer roulette game at an ETGT, Player 1 places bets in every round without missing a single one, while Player 2 skips a few rounds before placing additional bets. Players 3, 4, and 5 place bets sporadically, participating in some rounds but not others.

When the jackpot event is triggered, the system calculates each player's consecutive betting streak. Player 1, having bet in the most consecutive rounds, receives 60% of the $10,000 jackpot, earning $6,000. Player 2, with a shorter consecutive betting streak, receives 25%, or $2,500. Players 3, 4, and 5, with fewer consecutive bets, split the remaining $1,500.

This walk-through shows how the Jackpot Share for Consecutive Bets technique rewards players for their active, consistent participation throughout the session, encouraging sustained engagement.

### Example System Procedural Flow:

Tracking Consecutive Bets: The system monitors the sequence of bets each player places, logging how many consecutive rounds they bet on without skipping.

Bet Streak Calculation: When the jackpot event is triggered, the system calculates the length of each player's consecutive betting streak and assigns jackpot shares accordingly.

Jackpot Allocation:

### Mystery Jackpot Distribution Technique #47—Jackpot Share for Consecutive Bets (Continued)

### Example System Procedural Flow:

Jackpot Allocation: Players with the longest consecutive betting streaks receive the largest portions of the jackpot, while those with shorter streaks or who skipped rounds receive smaller shares.

Payout Process: The system displays each player's jackpot share, showing how their streak of consecutive bets influenced their payout.

Logging and Auditing: All bet data, consecutive streaks, and jackpot distributions are logged in the casino's central system for auditing and compliance purposes.

### Noteworthy Aspects and Features:

Incentivizes Consistent Play: Players are rewarded for remaining actively engaged in every round, encouraging sustained betting without interruptions.

Increases Betting Volume: By promoting consecutive betting, the technique boosts overall wagering activity, leading to higher revenue for the casino.

Encourages Longer Sessions: Players are motivated to keep placing bets in every round to maintain their streak and maximize their jackpot share.

Dynamic and Engaging: The focus on consecutive play adds excitement and strategy, as players must balance the benefits of consistency against the need for breaks.

### Mystery Jackpot Distribution Technique #48—Jackpot Share for Longest Losing Streak

### Description and Implementation:

The Jackpot Share for Longest Losing Streak technique rewards players who have endured the longest streak of losses during a game session. Rather than penalizing players for bad luck, this method turns a losing streak into an opportunity to win a significant portion of the jackpot. Players who experience the most consecutive losses qualify for larger shares of the jackpot when it is triggered, providing them with a chance to recover some of their losses.

In an ETGT or LDGT environment, the system tracks each player's win-loss record throughout the session, paying particular attention to consecutive losses. When the jackpot event occurs, players with the longest losing streaks are rewarded with a larger share of the jackpot, turning their bad fortune into a potential windfall.

### Benefits to Players:

Players benefit from this technique by being given a second chance to win, even if they have experienced a string of bad luck. This method alleviates some of the frustration that may come from long losing streaks, offering players a silver lining in the form of a larger jackpot payout. It also encourages players to stay engaged, knowing that even a losing streak may eventually lead to a reward. For players who feel discouraged by their losses, this technique provides a renewed sense of excitement and motivation to continue playing.

### Benefits to Casinos:

For casinos, the Jackpot Share for Longest Losing Streak technique increases player retention by giving losing players a reason to stay in the game. Rather than walking away after a series of losses, players are encouraged to continue participating in the hope of receiving a larger jackpot payout. This method also promotes longer play sessions and higher overall wagering, as players remain engaged even during tough streaks. Additionally, the technique helps create a more balanced and positive gaming experience, where even losing players feel like they have a chance to win big.

### Example Walk-Through Scenario:

In a live dealer poker game at an ETGT, five players are participating. Player 1 has the longest losing streak, having lost 10 consecutive hands. Player 2 has lost six consecutive hands, while Players 3, 4, and 5 have lost fewer than five hands in a row.

When the jackpot event is triggered, the system calculates the losing streaks of each player. Player 1, with the longest losing streak, receives 50% of the $12,000 jackpot, earning $6,000. Player 2, with a shorter streak, receives 30%, or $3,600. Players 3, 4, and 5, with shorter streaks, split the remaining 20%, each receiving $800.

This walk-through demonstrates how the Jackpot Share for Longest Losing Streak technique rewards players who have had a difficult run, providing them with a chance to recover some of their losses through the jackpot.

### Example System Procedural Flow:

Tracking Win-Loss Records: The system monitors each player's win and loss record throughout the session, paying special attention to consecutive losses.

Identifying Losing Streaks: When the jackpot event is triggered, the system evaluates the length of each player's losing streak and calculates their share of the jackpot.

Jackpot Allocation: Players with the longest losing streaks receive larger shares of the jackpot, while those with shorter streaks receive smaller portions.

Payout Process: The system displays each player's payout, showing how their losing streak influenced their share of the jackpot.

Logging and Auditing: All win-loss data, losing streaks, and jackpot distributions are logged in the casino's central system for auditing and compliance purposes.

### Noteworthy Aspects and Features:

Turns Losses into Opportunities: Players with long losing streaks are given a chance to win a larger jackpot share, turning bad luck into a potential reward.

Encourages Player Retention: The technique motivates players to stay engaged, even during losing streaks, as they have the potential to receive a significant payout.

Balances the Gaming Experience: By rewarding losing players, the method creates a more inclusive and balanced environment, where everyone has a chance to win.

Increases Playtime: Players are less to leave after experiencing losses, as they remain hopeful of recovering some of their losses through the jackpot.

### Mystery Jackpot Distribution Technique #49—Jackpot Share for Progressive Betting

### Description and Implementation:

The Jackpot Share for Progressive Betting technique rewards players who follow a progressive betting strategy, where they increase their bet size incrementally after each round or hand. This method encourages players to adopt a more aggressive betting strategy, gradually raising their stakes over time. Players who consistently increase their bets throughout the session are eligible for larger shares of the jackpot when it is triggered, rewarding their willingness to take on greater risks.

In an ETGT or LDGT environment, the system tracks the progression of each player's bets over time. Players who demonstrate a clear pattern of increasing their wagers after each round or game qualify for a larger portion of the jackpot. This technique incentivizes players to push their limits and adopt a high-risk, high-reward strategy, creating excitement and anticipation as their bets grow.

### Benefits to Players:

Players benefit from this technique by being rewarded for their willingness to take on more risk through progressive betting. This method appeals to players who enjoy building momentum and gradually increasing their stakes in pursuit of a larger payout. By progressively increasing their bets, players may qualify for a larger jackpot share, making the game more thrilling as their bets grow. For players who prefer a more aggressive approach to wagering, this technique provides a structured way to earn bigger rewards.

### Benefits to Casinos:

For casinos, the Jackpot Share for Progressive Betting technique drives higher betting volumes as players are incentivized to increase their stakes over time. The progressive betting strategy encourages players to take greater risks, leading to larger wagers and more substantial contributions to the jackpot pool. This method also promotes longer play sessions, as players remain engaged in the game while they work to build their betting progression. By fostering a more dynamic and high-stakes atmosphere, casinos may enhance the overall excitement and appeal of their games.

### Example Walk-Through Scenario:

In a live dealer blackjack game at an ETGT, Player 1 follows a progressive betting strategy, starting with $50 bets and increasing to $300 by the end of the session. Player 2 also adopts a similar approach, raising their bets from $25 to $150 over the course of several rounds. Players 3, 4, and 5 place more conservative, consistent bets throughout the session.

When the jackpot event is triggered, the system evaluates each player's betting progression. Player 1, who demonstrated the most significant bet progression, receives 50% of the $15,000 jackpot, earning $7,500. Player 2, with a smaller but steady progression, receives 30%, or $4,500. Players 3, 4, and 5, with more static betting strategies, split the remaining $3,000.

This walk-through shows how the Jackpot Share for Progressive Betting technique rewards players for their increasing wagers, encouraging a more aggressive and strategic approach to betting.

### Example System Procedural Flow:

Tracking Bet Progression: The system monitors each player's bet amounts over the course of the session, logging the progression of their wagers after each round.

Identifying Progressive Bettors: When the jackpot event is triggered, the system evaluates which players followed a progressive betting strategy and calculates their share of the jackpot accordingly.

Jackpot Allocation: Players who demonstrated the most significant bet progression receive the largest shares of the jackpot, while those with more conservative or static betting strategies receive smaller portions.

Payout Process: The system displays each player's payout, showing how their progressive betting influenced their share of the jackpot.

Logging and Auditing: All bet progression data, jackpot calculations, and payout details are logged in the casino's central system for auditing and compliance purposes.

### Noteworthy Aspects and Features:

Incentivizes High-Stakes Play: Players are rewarded for progressively increasing their bets, encouraging a more aggressive and exciting approach to betting.

Promotes Longer Play Sessions: The technique motivates players to stay in the game and build their betting progression, leading to extended playtimes.

Increases Wager Volume: By promoting progressive betting strategies, the method drives higher overall wagering activity and increases contributions to the jackpot pool.

Appeals to Risk-Takers: The technique is particularly attractive to

### Mystery Jackpot Distribution Technique #49—Jackpot Share for Progressive Betting (Continued)

Noteworthy Aspects and Features (continued):

Appeals to Risk-Takers: The technique is particularly attractive to players who enjoy taking risks and increasing their stakes over time. It provides a structured reward for adopting a high-risk, high-reward strategy.

Dynamic Payout Structure: By rewarding progressive bettors, the system adds an exciting and dynamic element to the game, where players are incentivized to push their betting limits in pursuit of larger jackpot shares.

### Mystery Jackpot Distribution Technique #50—Jackpot Share for Random Seat Selection

### Description and Implementation:

The Jackpot Share for Random Seat Selection technique allocates portions of the jackpot to players based on a random selection of their seat positions, regardless of their game performance or betting behavior. In this method, the system selects one or more seats at random during the jackpot event, and the players occupying those seats receive a share of the jackpot. This method introduces an element of pure chance, providing every player with an equal opportunity to win a portion of the jackpot, regardless of their skill level or betting activity.

In an ETGT or LDGT environment, the system randomly selects seat numbers when the jackpot event is triggered. Players seated in those positions receive a predetermined share of the jackpot, adding an extra layer of excitement and surprise to the game. The randomness ensures that all players, regardless of their performance or risk-taking, have an equal chance of winning.

### Benefits to Players:

Players benefit from this technique by having an equal opportunity to win a share of the jackpot, regardless of their skill level, betting behavior, or game performance. This method adds an element of surprise and fairness, making the game more inclusive and giving everyone a chance to win. It also appeals to players who may prefer a less competitive or skill-based approach to jackpot participation, as luck plays a central role in determining the winners.

### Benefits to Casinos:

For casinos, the Jackpot Share for Random Seat Selection technique encourages broad player participation, as all players know they have an equal chance of winning the jackpot, regardless of how they play the game. This method helps maintain a positive and engaging atmosphere, where even low-stakes or less experienced players feel involved and motivated to stay in the game. By incorporating an element of randomness, casinos may enhance the overall excitement and appeal of the gaming experience, keeping players engaged and encouraging them to continue participating.

### Example Walk-Through Scenario:

In a live dealer poker game at an ETGT, five players are seated at the table. When the jackpot event is triggered, the system randomly selects two seat positions—Seats 1 and 4. Player 1, sitting in Seat 1, receives 60% of the $10,000 jackpot, earning $6,000, while Player 4 receives 40%, or $4,000. Players in Seats 2, 3, and 5 do not receive a share of the jackpot, as their seats were not selected.

This walk-through illustrates how the Jackpot Share for Random Seat Selection technique introduces an element of chance into the jackpot distribution, giving all players an equal opportunity to win, regardless of their betting patterns or performance.

### Example System Procedural Flow:

Random Seat Selection: When the jackpot event is triggered, the system randomly selects one or more seat positions from the pool of active players.

Jackpot Allocation: Players sitting in the randomly selected seats receive predetermined shares of the jackpot, with the system allocating the funds according to the number of selected seats.

Payout Process: The system displays the seat numbers that were selected and the corresponding jackpot shares awarded to the players in those positions.

Logging and Auditing: All seat selections, jackpot allocations, and payout details are logged in the casino's central system for auditing and compliance purposes.

### Noteworthy Aspects and Features:

Pure Chance: The technique relies entirely on luck, giving all players an equal opportunity to win, regardless of their skill or betting activity.

Inclusive for All Players: Every player has a fair chance of winning, making the game more accessible and enjoyable for both high-stakes and low-stakes participants.

Element of Surprise: The randomness adds excitement and anticipation to the game, as players eagerly await the seat selection to see if they are chosen.

Promotes Player Retention: By offering a chance for anyone to win, the technique encourages more players to stay engaged in the game, knowing they may be selected for the jackpot.

### Mystery Jackpot Distribution Technique #51—Jackpot Share for Lowest Risk Players

### Description and Implementation:

The Jackpot Share for Lowest Risk Players technique rewards players who consistently place lower-risk bets during the game session. Unlike methods that focus on high-stakes or aggressive betting, this technique recognizes players who adopt a conservative betting strategy, placing lower bets or making less risky decisions. Players who maintain this low-risk approach throughout the session receive larger portions of the jackpot when it is triggered, rewarding their cautious and calculated gameplay.

In an ETGT or LDGT environment, the system monitors each player's betting behavior, focusing on bet sizes and risk levels. Players who place consistently smaller, less risky bets are identified, and when the jackpot is triggered, those who exhibited the most conservative betting strategy are allocated larger shares of the jackpot. This method provides a way for low-stakes players to qualify for significant rewards, leveling the playing field for all participants.

### Benefits to Players:

Players benefit from this technique by being rewarded for adopting a cautious, low-risk betting strategy. This method appeals to players who prefer to play conservatively but still want the opportunity to win a substantial portion of the jackpot. It provides a sense of security and fairness, allowing lower-stakes players to compete for the jackpot alongside high-stakes players. Additionally, the technique introduces a strategic element, where players may focus on risk management to maximize their potential reward.

### Benefits to Casinos:

For casinos, the Jackpot Share for Lowest Risk Players technique encourages broad participation from a variety of players, including those who may be less inclined to take big risks. By rewarding cautious play, casinos may create a more inclusive gaming environment that appeals to a wider audience. This method also promotes longer play sessions, as conservative players are incentivized to remain engaged in the game, knowing that their careful strategy may lead to a larger jackpot payout. Additionally, the system helps balance risk across the table, ensuring that low-risk and high-risk players both have opportunities to win.

### Example Walk-Through Scenario:

In a live dealer roulette game at an ETGT, Player 1 consistently places small, low-risk outside bets such as betting on red or black, while Players 2 and 3 place more aggressive bets on specific numbers or combinations. Players 4 and 5 alternate between low-risk and higher-risk strategies.

When the jackpot event is triggered, the system evaluates the risk levels of each player's bets. Player 1, having maintained the lowest-risk betting strategy throughout the session, receives 50% of the $8,000 jackpot, earning $4,000. Players 2 and 3, with higher-risk strategies, receive smaller portions, while Players 4 and 5 split the remaining amount based on their moderate risk levels.

This walk-through illustrates how the Jackpot Share for Lowest Risk Players technique rewards cautious players, giving them the opportunity to win significant jackpots even when playing conservatively.

### Example System Procedural Flow:

Tracking Bet Risk: The system monitors each player's bets, categorizing them by risk level based on bet size, odds, and payout potential.

Identifying Lowest Risk Players: When the jackpot event is triggered, the system identifies players who placed the lowest-risk bets over the course of the session.

Jackpot Allocation: Players with the most consistent low-risk betting strategies receive larger shares of the jackpot, while those who took on more risk receive smaller portions.

Payout Process: The system displays each player's jackpot share and explains how their low-risk strategy influenced their payout.

Logging and Auditing: All risk data, jackpot calculations, and payout details are logged in the casino's central system for auditing and compliance purposes.

### Noteworthy Aspects and Features:

Rewards Conservative Play: Players who adopt a cautious, low-risk approach are rewarded with larger jackpot shares, creating a balanced and inclusive gaming environment.

Appeals to Low-Stakes Players: The technique provides an opportunity for low-stakes players to compete for the jackpot alongside high-stakes participants, leveling the playing field.

Encourages Longer Play: Conservative players are incentivized to remain engaged, knowing that their careful strategy may lead to a significant reward.

Balanced Risk Distribution: By rewarding both low-risk and high-risk players, the method creates a more dynamic and balanced game, appealing to a wide range of participants.

### Mystery Jackpot Distribution Technique #52—Jackpot Share for Frequent Small Wins

### Description and Implementation:

The Jackpot Share for Frequent Small Wins technique rewards players who achieve a series of small wins throughout the game session. Rather than focusing on large, one-time victories, this method recognizes players who consistently win smaller amounts over multiple rounds. Players who accumulate these frequent small wins are eligible for larger shares of the jackpot when it is triggered, encouraging steady and consistent gameplay.

In an ETGT or LDGT environment, the system tracks each player's win history, focusing on the frequency and size of their wins. Players who achieve numerous small wins over the session are identified, and when the jackpot is triggered, those with the most frequent wins are allocated a larger portion of the jackpot. This method rewards players for steady progress, making the game more exciting for those who prefer a slower, more methodical approach to wagering.

### Benefits to Players:

Players benefit from this technique by being rewarded for their consistency and ability to achieve multiple small wins throughout the session. This method appeals to players who prefer steady, incremental success rather than pursuing high-risk, high-reward outcomes. It offers a sense of accomplishment and progression, as players may see their small victories accumulate and lead to a substantial jackpot payout. The technique also provides a more forgiving and balanced approach for players who may not be comfortable taking big risks but still want to participate in jackpot rewards.

### Benefits to Casinos:

For casinos, the Jackpot Share for Frequent Small Wins technique encourages longer and more consistent play sessions, as players are motivated to accumulate small wins over time. By rewarding frequent, lower-stakes victories, casinos may appeal to a broader range of players, including those who prefer a more cautious and methodical approach to betting. This method helps maintain steady betting activity, contributing to a more balanced gaming environment where both high-risk and low-risk strategies are rewarded. Additionally, the technique promotes player retention, as players stay engaged in the pursuit of small, consistent wins that contribute to their overall jackpot eligibility.

### Example Walk-Through Scenario:

In a live dealer blackjack game at an ETGT, five players are participating. Player 1 achieves multiple small wins throughout the session, consistently winning hands with modest bets. Player 2 also secures frequent small victories, while Players 3, 4, and 5 focus on higher-risk, larger bets, experiencing fewer wins overall.

When the jackpot event is triggered, the system evaluates each player's win frequency. Player 1, who achieved the most small wins, receives 50% of the $10,000 jackpot, earning $5,000. Player 2, with a slightly lower frequency of wins, receives 30%, or $3,000. Players 3, 4, and 5, with fewer overall wins, split the remaining 20%, each receiving $666.

This scenario demonstrates how the Jackpot Share for Frequent Small Wins technique rewards players for their consistent and incremental success, offering them a path to significant rewards through steady, methodical play.

### Example System Procedural Flow:

Tracking Win Frequency: The system monitors each player's win history, focusing on the frequency and size of their victories throughout the session.

Identifying Frequent Small Winners: When the jackpot event is triggered, the system identifies players who achieved the most frequent small wins and calculates their share of the jackpot accordingly.

Jackpot Allocation: Players with the most frequent small wins receive larger portions of the jackpot, while those with fewer or larger but less frequent wins receive smaller shares.

Payout Process: The system displays each player's payout, explaining how their consistent small victories contributed to their jackpot share.

Logging and Auditing: All win frequency data, jackpot calculations, and payout details are logged in the casino's central system for auditing and compliance purposes.

### Noteworthy Aspects and Features:

Rewards Consistency: Players are incentivized to aim for steady, small wins, rather than relying on high-risk, high-reward strategies, making the game more accessible.

Encourages Longer Play: The method promotes extended play sessions, as players are motivated to stay engaged in the pursuit of frequent, small victories that accumulate toward a larger jackpot reward.

Balanced Gameplay: The technique provides a balanced approach to jackpot distribution, rewarding both cautious and aggressive players, creating a dynamic gaming environment.

Appeals to Methodical Players: Players who enjoy a slower, more strategic approach to betting are rewarded for their steady, incremental success.

Mystery Jackpot Distribution Technique #53—Jackpot Share for Players with the Most Ties or Draws

### Description and Implementation:

The Jackpot Share for Players with the Most Ties or Draws technique rewards players who experience the most tie or draw outcomes during their gaming session. In games like baccarat or blackjack, where ties are a common occurrence, this technique allows players to qualify for larger portions of the jackpot based on how frequently they encounter tie outcomes. This method introduces an element of randomness, as tie outcomes are generally rare but may still significantly impact the game.

In an ETGT or LDGT environment, the system tracks how often each player encounters a tie or draw in the rounds they participate in. When the jackpot event is triggered, players who have experienced the most ties or draws receive larger portions of the jackpot. This technique adds a new layer of excitement to the game, as players may capitalize on ties, which are typically seen as neutral or negative outcomes, to win larger rewards.

### Benefits to Players:

Players benefit from this technique by being rewarded for experiencing ties, outcomes that are usually viewed as non-advantageous. This method turns these seemingly neutral results into potential opportunities for winning a significant jackpot share. It offers a fresh perspective on ties and draws, making them exciting events rather than disappointments. Players who often find themselves in tie situations now have a chance to benefit from these outcomes, creating a more engaging and unpredictable gaming experience.

### Benefits to Casinos:

For casinos, the Jackpot Share for Players with the Most Ties or Draws technique encourages players to remain engaged, even when they experience tie outcomes. Rather than seeing ties as a neutral or negative result, players are motivated to stay in the game, knowing that frequent ties may lead to a larger jackpot payout. This method also adds an element of randomness and unpredictability to the jackpot distribution, making the gaming experience more dynamic and exciting. Additionally, it helps maintain player retention, as even seemingly unremarkable outcomes like ties may contribute to a player's overall success in the game.

### Example Walk-Through Scenario:

In a live dealer baccarat game at an ETGT, five players are participating. Player 1 experiences the most ties, with six occurring throughout the session. Player 2 encounters four ties, while Players 3, 4, and 5 have two or fewer ties each.

When the jackpot event is triggered, the system evaluates the number of ties each player experienced. Player 1, with the most ties, receives 50% of the $8,000 jackpot, earning $4,000. Player 2, with fewer ties, receives 30%, or $2,400, while Players 3, 4, and 5 split the remaining 20%, each receiving $533.

This scenario shows how the Jackpot Share for Players with the Most Ties or Draws technique turns seemingly neutral outcomes into opportunities for significant rewards, encouraging players to remain engaged in the game even when ties occur.

### Example System Procedural Flow:

Tracking Tie Outcomes: The system monitors how often each player encounters tie or draw outcomes during the session, logging the frequency of these events.

Identifying Tie Frequencies: When the jackpot event is triggered, the system identifies which players experienced the most ties or draws and calculates their share of the jackpot accordingly.

Jackpot Allocation: Players with the most tie outcomes receive larger portions of the jackpot, while those with fewer ties receive smaller shares.

Payout Process: The system displays each player's jackpot share and explains how their experience with ties influenced their payout.

Logging and Auditing: All tie frequency data, jackpot calculations, and payout details are logged in the casino's central system for auditing and compliance purposes.

### Noteworthy Aspects and Features:

Turns Ties into Rewards: Players who experience the most ties are rewarded for what is typically seen as a neutral or negative outcome, creating new opportunities for winning.

Encourages Engagement: Even when ties occur, players remain engaged in the game, knowing that frequent ties may contribute to a larger jackpot payout.

Unpredictable and Exciting: The method adds an element of randomness and excitement to the game, making every tie or draw an opportunity for bigger rewards.

Balances Luck and Strategy: By incorporating ties into the jackpot distribution, the technique balances skill-based play with elements of chance, making the game more dynamic.

### Mystery Jackpot Enabling-Disabling Criteria Example Embodiments

### Mystery Jackpot Enabling/Disabling Criteria #1—Time-Limited Enabling Windows

Description and Implementation: This Mystery Jackpot enabling criterion is designed to activate the jackpot functionality only during predefined time windows, such as peak casino hours (e.g., from 6:00 PM to 8:00 PM). This criterion helps casinos control jackpot activity and incentivize players to engage in gaming during high-traffic periods. The enabling window may be configured by the casino's management, allowing flexibility in determining when the jackpot is active.

For implementation at Live Dealer Game Tables (LDGTs) and Electronic Table Game Terminals (ETGTs), the casino's central system coordinates with game servers to enable the Mystery Jackpot feature during the set time period. The enabling time window is prominently displayed on each terminal, alerting players that the jackpot is active, which may create a sense of urgency to place more bets and participate within the available time frame. After the time window expires, the system automatically disables the feature, removing the jackpot option from the game interface until the next set window.

Benefits to Players: Players benefit from this system as it heightens excitement and anticipation, particularly during peak gaming hours. The limited availability of the Mystery Jackpot encourages participation by creating a “now or never” mentality. This urgency may increase the adrenaline rush and make the gaming session more thrilling. Additionally, players are incentivized to extend their playtime to ensure they remain at the table when the jackpot becomes available. Promotions around specific time-limited jackpots may also appeal to players who plan their gaming schedules around such events.

Benefits to Casinos: Casinos benefit by being able to control when high jackpot payouts occur, aligning jackpot features with peak business hours to maximize player traffic. Time-limited jackpots may also reduce overall jackpot payout frequency, keeping the jackpot pool well-funded. By attracting more players during specific periods, casinos may optimize staffing and service resources, improving operational efficiency. Furthermore, time-based promotions encourage longer stays, increasing the number of bets placed, and ultimately boosting revenue.

### Example Walk-Through Scenario:

A player named John arrives at a casino at 5:45 PM, anticipating the upcoming 6:00 PM Mystery Jackpot activation period. He chooses an ETGT at the live dealer-controlled baccarat table. As the clock nears 6:00 PM, the ETGT displays a message indicating that the Mystery Jackpot feature will be enabled shortly. John places a few low-value bets to warm up, but at exactly 6:00 PM, the system announces that the jackpot is now live, displaying the potential prize pool amount across all terminals.

John, knowing the window is limited to two hours, begins placing larger bets to increase his chances of triggering the jackpot. During each round of baccarat, the system informs him of the remaining time in the jackpot window. As more players notice the jackpot activation, more seats at the baccarat table fill up, with everyone keen on trying their luck. At 7:55 PM, John places a final high-stakes bet, hoping to win before the jackpot window closes. The jackpot is not triggered, but John remains entertained throughout the session, enjoying the thrill of the limited-time offer.

At exactly 8:00 PM, the system deactivates the Mystery Jackpot feature. The ETGTs immediately display a message that the jackpot is no longer available, and the interface reverts to standard game play. Players are informed that the next jackpot activation period will occur the following evening.

### Example System Procedural Flow:

1. Time Synchronization and Setup: The casino management system configures the specific time windows during which the Mystery Jackpot will be active, sending this schedule to all LDGTs and ETGTs connected to the casino network. The system clock is synchronized across all terminals to ensure consistent operation.
2. Pre-Jackpot Announcement: 10 minutes before the scheduled time, a countdown is triggered, and the ETGTs display a notification that the Mystery Jackpot will soon be enabled. Players at the terminals receive a visual and auditory cue to prepare for the jackpot period.
3. Jackpot Activation: At the designated time (e.g., 6:00 PM), the casino network system communicates with all ETGTs, activating the Mystery Jackpot feature by unlocking the jackpot functionality within the game software. All bets placed from this moment become eligible for jackpot participation.
4. Player Interactions and Bets: As players place their bets during the active jackpot window, the ETGT tracks the value and outcome of each bet, transmitting this data to the casino's central server. The server calculates contributions to the jackpot pool and continuously updates the jackpot value displayed on each terminal.
5. Time Expiry and Jackpot Deactivation: As the jackpot time window approaches closure (e.g., 8:00 PM), a final countdown is displayed across all terminals. Once the time limit is reached, the jackpot feature is disabled by the system, and all relevant interface elements are removed. Bets placed after this time are no longer eligible for jackpot participation.
6. Data Processing and Reporting: Throughout the jackpot activation period, the system logs all jackpot-related activity. This data is used to generate reports for casino management, indicating total jackpot contributions, player participation, and jackpot payout performance.

### Noteworthy Aspects and Features:

Time-Based Control: The ability to schedule jackpots during specific timeframes is a novel feature that allows casinos to fine-tune jackpot availability based on player traffic patterns and operational goals.
Automated Jackpot Management: The seamless activation and deactivation of jackpot features through centralized control and real-time synchronization with all ETGTs reduces the need for manual intervention, ensuring accurate and fair execution.
Player Experience Enhancement: The countdown and notifications leading up to and during the jackpot activation create a heightened sense of excitement and urgency. This system encourages players to remain engaged for extended periods and motivates higher-stakes bets during the jackpot window.
Real-Time Updates and Transparency: Players are kept informed of the jackpot status at all times, ensuring transparency in how the jackpot is managed and when it is available, which fosters trust in the gaming system.

This novel approach to timed jackpot activation is particularly attractive in regions like Macau, where gaming schedules and high-stakes play are central to the casino experience. By aligning jackpot opportunities with peak play hours, casinos may maximize both participation and revenue.

### Mystery Jackpot Enabling/Disabling Criteria #2—Jackpot Pool Size Trigger

Description and Implementation: This Mystery Jackpot enabling criterion triggers the jackpot functionality when the jackpot pool reaches a specific value (e.g., $50,000). The feature automatically disables once the pool size drops below the threshold. This criterion may be implemented in Live Dealer Game Tables (LDGTs) and Electronic Table Game Terminals (ETGTs) by linking all relevant game terminals to a central jackpot pool managed by the casino's server. The system continuously monitors the jackpot fund, which increases incrementally with each qualifying bet. When the threshold value is met, the jackpot feature becomes active, allowing players to potentially win the jackpot.

For example, once the collective pool reaches $50,000, a notification appears on all active ETGTs and LDGTs, indicating that the jackpot is live. The pool size is prominently displayed on the game interface, encouraging players to continue betting to increase their chances of winning. The system automatically manages the jackpot, disabling it once a payout is made and the pool size falls below the threshold.

Benefits to Players: Players are incentivized to continue participating as they track the growing jackpot pool. Once the pool hits a predetermined amount, the excitement increases, as the opportunity to win a significant sum becomes real. The dynamic nature of the increasing jackpot pool also adds suspense, drawing players to watch for when the jackpot becomes active. Players feel more motivated to place higher-value bets to capitalize on the rare window of opportunity when the jackpot pool is sufficiently large.

Benefits to Casinos: Casinos benefit by setting thresholds that align with their financial strategy, allowing them to control when large jackpots are distributed. The casino also sees increased player engagement as patrons are to continue playing to push the jackpot pool to the required level. This criterion helps maintain a healthy balance between player excitement and jackpot payouts. Moreover, by regulating jackpot payouts based on pool size, casinos may protect against excessive payouts and manage their long-term profitability.

### Example Walk-Through Scenario:

At a busy baccarat table, a group of players have been steadily contributing to the jackpot pool through their side bets. Over the course of several rounds, the jackpot pool, which started at $20,000, gradually grows with each contribution. The game interface prominently displays the increasing pool amount, with players eagerly anticipating the moment it will cross the $50,000 threshold. As the jackpot pool nears $49,500, player activity at the table intensifies. John, a regular player, increases his bets, knowing that the jackpot is close to becoming active.

Finally, during a high-stakes round, the pool crosses $50,000, triggering the Mystery Jackpot. All players at the table receive a notification on their ETGTs that the jackpot is now live. John places a side bet to qualify for the jackpot, and after a few more rounds, the winning hand is dealt, and one lucky player claims the prize. The system deducts the jackpot amount, and the pool returns to its initial value of $10,000. The game continues, and the cycle of contributing to the pool begins again.

### Example System Procedural Flow:

1. Pool Size Monitoring: The casino network server constantly monitors the cumulative pool size, aggregating data from all connected ETGTs and LDGTs.
2. Data Logging and Bet Contribution: As players place bets, a portion of each qualifying bet is allocated to the jackpot pool. The system updates the pool size in real-time, displaying the current total on all active terminals.
3. Threshold Reached: When the jackpot pool reaches the threshold (e.g., $50,000), the system sends a notification to all terminals, enabling the Mystery Jackpot functionality. Bets placed after this point are eligible for the jackpot.
4. Jackpot Activation: During the active jackpot period, player interactions with the game are tracked. The system identifies qualifying bets, logging each player's participation in the jackpot pool.
5. Jackpot Payout: Once a player hits the jackpot, the system automatically deducts the jackpot amount from the pool and disburses the winnings to the player's account. The jackpot pool resets to a lower base value (e.g., $10,000) and resumes accumulating contributions.
6. Post-Jackpot Period: The system disables the jackpot feature until the pool size once again meets or exceeds the threshold, ensuring that no premature jackpots occur.

### Noteworthy Aspects and Features:

Automatic Management of Jackpot Funds: The system seamlessly tracks contributions and manages payouts, reducing the need for manual intervention by the casino staff.
Real-Time Tracking and Display: Players may observe the jackpot pool growing in real-time, which adds an engaging, competitive element to the gaming experience.
Threshold Control: Casinos have full control over the jackpot trigger point, allowing them to optimize when and how frequently jackpots are awarded based on the size of the pool.

### Mystery Jackpot Enabling/Disabling Criteria #3—Consecutive Player Wins

Description and Implementation: This enabling criterion activates the Mystery Jackpot when a player achieves a set number of consecutive wins (e.g., three consecutive rounds). The system tracks each player's performance at the LDGTs and ETGTs and only enables the jackpot once the defined streak is reached. The software on the casino network continuously monitors each player's performance at the table, identifying when a player is eligible for the jackpot after the required number of consecutive wins. For instance, after a player wins three hands in a row at a blackjack table, the system triggers the jackpot feature, making the player eligible for a large prize. The consecutive win criterion creates a sense of accomplishment for players, rewarding them for skilled or lucky play.

Benefits to Players: Players are rewarded for their skill or good fortune, making consecutive wins more exciting. This criterion adds an element of progression to the game, as players see their winning streaks as a pathway to unlocking the jackpot. It also keeps players engaged, as they focus on stringing together multiple wins to become eligible for a substantial reward.

Benefits to Casinos: Casinos benefit by offering a jackpot that is not randomly distributed but based on player performance. This criterion encourages players to remain at the table longer, especially after winning a round, as they aim to reach the consecutive win threshold. The extended playtime and increased betting frequency contribute to higher revenues. Additionally, the feature helps differentiate the casino's gaming experience, making it more attractive to players seeking skill-based rewards.

### Example Walk-Through Scenario:

Samantha sits down at an ETGT to play blackjack and starts off with a winning hand. Encouraged by her success, she places another bet, and after a tense round, she wins again. The system displays her win streak, showing that she is just one win away from qualifying for the Mystery Jackpot. With heightened excitement, Samantha places a larger bet, knowing that a third consecutive win will trigger the jackpot eligibility.

On the next hand, Samantha wins again, and a special notification appears on her screen, indicating that she is now eligible for the Mystery Jackpot. The jackpot pool, which had been building throughout the day, is now open to her. She places an additional side bet to participate in the jackpot, and within a few rounds, the jackpot is won. The system resets her win streak, but the experience of reaching the threshold keeps her engaged for more rounds.

### Example System Procedural Flow:

1. Player Win Tracking: The system continuously monitors the outcomes of each player's bets, logging wins and losses.
2. Win Streak Verification: When a player achieves a consecutive win (e.g., two wins), the system updates the player's streak and displays the current count on their screen. If the player loses, the streak is reset.
3. Threshold Reached: After a specified number of consecutive wins, the system activates the Mystery Jackpot feature for that player, displaying a notification and updating their game interface.
4. Jackpot Participation: The player is now eligible to place side bets for the Mystery Jackpot. The system tracks these side bets and records contributions to the jackpot pool.
5. End of Streak: If the player loses a round, the win streak is reset, and the player is no longer eligible for the jackpot until another streak is built.

### Noteworthy Aspects and Features:

Performance-Based Jackpot: Unlike random jackpot systems, this criterion rewards players for achieving consecutive wins, making it more appealing to skill-focused players.
Continuous Engagement: Players are more to stay engaged after consecutive wins, fostering a sense of momentum that keeps them playing for longer periods.
Dynamic Interface: The system updates players on their progress, providing clear feedback on how close they are to unlocking the jackpot.

### Mystery Jackpot Enabling/Disabling Criteria #4—Randomized Enabling Periods

Description and Implementation: This criterion involves activating the Mystery Jackpot at random intervals, creating an unpredictable gaming experience. Unlike time-limited windows or performance-based triggers, this system relies on a random number generator (RNG) to determine when the jackpot feature is enabled. At any moment, the system may activate the jackpot, making every game session feel dynamic and exciting.

The implementation involves the casino's server system running RNG algorithms that determine the enabling periods. The software on the ETGTs and LDGTs then receives instructions from the central system to activate or deactivate the jackpot feature based on these random triggers. Notifications are pushed to all active game terminals when the jackpot becomes live.

Benefits to Players: Players benefit from the unpredictability of this feature, as it adds excitement to every round. The randomized nature of the jackpot means that any moment may present a chance to win big, keeping players on the edge of their seats. The randomness also levels the playing field, giving all players an equal opportunity to participate, regardless of their skill level.

Benefits to Casinos: Casinos may use this criterion to generate sustained excitement across the gaming floor. The random activation of the jackpot encourages players to continue betting, as they never know when the next jackpot opportunity will arise. The unpredictability also leads to spontaneous spikes in player activity, as patrons scramble to participate once the jackpot is enabled. This feature may lead to increased player retention and a higher volume of bets placed over time.

### Example Walk-Through Scenario:

Tom is casually playing at an ETGT, placing moderate bets on a series of baccarat rounds. Suddenly, the screen flashes with a message: “Mystery Jackpot Activated!” The notification catches Tom off guard, but he quickly places a side bet to enter the jackpot. Other players at the table also respond to the notification, and the excitement builds as everyone participates in the surprise jackpot window. Over the next 10 minutes, multiple players place high-stakes bets in hopes of hitting the jackpot.

After several rounds, the jackpot window closes, and the system announces that the jackpot opportunity has ended. Players eagerly anticipate the next random activation, and Tom continues playing, knowing that the jackpot may reappear at any moment.

### Example System Procedural Flow:

1. RNG-Based Activation: The casino server runs a random number generator to determine when the jackpot will be enabled. The system is designed to randomly activate the jackpot feature at unexpected times.
2. Notification to Players: When the RNG triggers an activation, all connected ETGTs and LDGTs receive a notification that the jackpot is now live. Players are alerted through visual and audio cues on their terminals.
3. Player Response and Participation: Players who wish to participate place side bets, and the system logs these bets, tracking contributions to the jackpot pool.
4. Random Deactivation: After a set period or once certain criteria are met, the system randomly deactivates the jackpot, notifying players that the opportunity has ended.
5. Data Logging and Pool Management: The system tracks the entire process, updating the jackpot pool and logging all player interactions for future reporting.

### Noteworthy Aspects and Features:

Unpredictability and Excitement: The random nature of the activation creates an atmosphere of surprise, keeping players continuously engaged.
Level Playing Field: Since the jackpot is not tied to performance or betting volume, all players have an equal chance of participating, regardless of their strategy or stake level.
Dynamic Casino Environment: The sudden activation of the jackpot may create excitement across the casino, driving increased engagement from a broad range of players.

### Mystery Jackpot Enabling/Disabling Criteria #5—High Bet Activation

Description and Implementation: This criterion enables the Mystery Jackpot feature when a player places a bet above a certain amount (e.g., $1,000 or more). The system is designed to recognize high-stakes bets and activate the jackpot feature exclusively for those players who meet the minimum betting requirement. The high bet criterion may be implemented across LDGTs and ETGTs by integrating with the casino's bet-tracking software, which continuously monitors bet sizes across all terminals.

For example, when a player places a bet of $1,000, the system activates the jackpot feature for that player's terminal. This feature encourages high-stakes betting, as only those who meet the minimum threshold are eligible to win the jackpot.

Benefits to Players: Players who enjoy high-stakes gaming are rewarded with exclusive access to the Mystery Jackpot. This feature appeals to VIP players and high-rollers who seek higher rewards for their substantial bets. It also creates a more elite experience, as only a select group of players may participate in the jackpot, enhancing the perceived value of the game.

Benefits to Casinos: Casinos benefit from increased revenue, as players are motivated to place higher-value bets to access the Mystery Jackpot. This criterion encourages high-roller activity, which is particularly beneficial for generating larger jackpot pools and maintaining a premium gaming experience. Additionally, casinos may use this feature to target their VIP clientele, offering them exclusive jackpot opportunities.

### Example Walk-Through Scenario:

At a high-stakes baccarat table, Michael, a VIP player, places a bet of $2,000. As soon as his bet is confirmed, a notification appears on his screen, indicating that he has qualified for the Mystery Jackpot. Other players at the table, placing smaller bets, do not receive this notification. Michael knows that by placing such a large bet, he has unlocked the potential to win a jackpot, which adds excitement to his already high-stakes game.

Michael continues to place large bets, each time ensuring that he meets the minimum threshold to remain eligible for the jackpot. After several rounds, the jackpot is triggered, and Michael wins a substantial prize, reinforcing his loyalty to the casino.

### Example System Procedural Flow:

1. Bet Monitoring: The ETGTs and LDGTs continuously monitor player bets. When a player places a bet above the defined threshold (e.g., $1,000), the system logs this information and checks if the player is eligible for the jackpot.
2. Eligibility Check: Once the high bet is confirmed, the system activates the Mystery Jackpot feature for that player. A notification is displayed, indicating that the player is eligible for the jackpot.
3. Jackpot Participation: The player may now place side bets to participate in the jackpot. The system tracks these side bets and contributions to the jackpot pool.
4. Payout Process: If the player wins the jackpot, the system calculates the payout and deducts the amount from the pool. The player's eligibility is reset after each round, requiring another high-stakes bet to requalify.

### Noteworthy Aspects and Features:

Exclusive Access: By tying jackpot eligibility to high-stakes bets, casinos may create an elite, high-value gaming experience that appeals to their most valuable players.
Revenue Boost: The requirement for higher bets increases overall bet volumes, leading to larger jackpot pools and higher revenue for the casino.
Real-Time Player Tracking: The system's ability to track bet sizes in real-time ensures that the jackpot is only available to those who meet the specific criteria, creating a fair and transparent gaming experience.

### Mystery Jackpot Enabling/Disabling Criteria #6—Player Entry Requirement

Description and Implementation: This enabling criterion activates the Mystery Jackpot when a specific number of players (e.g., six or more) are simultaneously participating at a Live Dealer Game Table (LDGT) or at an Electronic Table Game Terminal (ETGT) session. The casino gaming network monitors player participation across all connected game terminals, triggering the jackpot feature once the required player threshold is met.

At the ETGT level, software systems continually track player occupancy and communicate with the casino's central server to determine when enough players are active at the table. For example, in a scenario where the threshold is set at six players, the jackpot feature is activated as soon as the sixth player joins the game. If the number of participants drops below the required number, the feature is automatically disabled. This system incentivizes players to fill tables quickly to unlock the jackpot opportunity.

Benefits to Players: Players benefit from the social dynamic that encourages group participation. By requiring a minimum number of players, this criterion fosters a sense of community and camaraderie as players work together to meet the entry requirement for the jackpot. Additionally, players may experience increased excitement knowing that the presence of more participants leads to the activation of a valuable jackpot.

Benefits to Casinos: Casinos benefit from increased table occupancy rates, as players are motivated to fill up tables quickly to trigger the jackpot. This criterion also leads to longer play sessions, as players are to stay once the jackpot is active, especially if there is a risk of the player count dropping and disabling the feature. By promoting full tables, casinos may optimize the utilization of their gaming floor, maximizing potential revenue per table.

### Example Walk-Through Scenario:

A group of four players are seated at an ETGT baccarat table, with two vacant spots remaining. The players are aware that the Mystery Jackpot feature may require a minimum of six players to be activated. They each continue playing, waiting for more players to join. As the game proceeds, two more players, Maria and Thomas, decide to sit down and join the table. The moment the sixth player places their bet, the system triggers the Mystery Jackpot, and a notification appears on all players' screens announcing that the jackpot feature is now live.

Excited by the activation, Maria places a side bet for a chance to win the jackpot, as do several other players. Over the next few rounds, the game becomes more intense as each player eagerly awaits the outcome of the jackpot. Eventually, the jackpot is won by one of the players, and the feature is deactivated until the player count drops and rises again to meet the minimum threshold.

### Example System Procedural Flow:

1. Player Count Monitoring: The ETGTs and LDGTs continuously track the number of active players participating in the game. The data is sent to the central casino server, where it is processed in real-time.
2. Threshold Check: Once the player count reaches the defined threshold (e.g., six players), the server sends a signal to all connected terminals, enabling the Mystery Jackpot feature.
3. Jackpot Activation: The jackpot becomes available, and players are notified via on-screen messages. They are now able to place side bets for jackpot participation.
4. Continuous Player Count Monitoring: The system continues to monitor the player count. If the number of active participants drops below the required threshold, the system disables the jackpot, and the feature is no longer available.
5. Data Logging and Reporting: All player interactions, side bets, and contributions to the jackpot pool are logged by the system, enabling detailed reporting for casino management.

### Noteworthy Aspects and Features:

Collaborative Gameplay: This criterion fosters group participation, encouraging players to invite others to join in order to activate the jackpot.
Table Optimization: By requiring a minimum number of players, the system ensures that tables are fully utilized, optimizing the casino's floor layout and enhancing the overall gaming atmosphere.
Automatic Activation/Deactivation: The system seamlessly activates and deactivates the jackpot based on player participation, creating a dynamic and responsive gameplay environment.

### Mystery Jackpot Enabling/Disabling Criteria #7—Dealer Event Trigger

Description and Implementation: This criterion enables the Mystery Jackpot feature when a dealer achieves a specific event or outcome, such as hitting a blackjack, a perfect 21, or a streak of consecutive wins. The feature is closely tied to the performance of the dealer and is activated automatically when the event occurs. The casino system monitors the dealer's actions in real-time, and when the pre-defined event happens, the system triggers the jackpot functionality across all connected terminals at the LDGT.

For instance, during a blackjack game, the system tracks the dealer's hand, and if the dealer hits a blackjack, the Mystery Jackpot is immediately enabled, allowing all players at the table to participate in the jackpot. The system remains active until the next dealer change or another specific trigger event occurs.

Benefits to Players: This feature adds an exciting twist to gameplay, where the dealer's success directly impacts the player's opportunity to win the jackpot. It turns dealer outcomes into a shared experience, creating moments of surprise and celebration when the dealer hits the qualifying event. Players feel more connected to the action, as they are rooting for the dealer to trigger the jackpot. This dynamic enhances the overall excitement of the game and provides a unique avenue for players to engage with the dealer.

Benefits to Casinos: By linking the jackpot feature to dealer performance, casinos may introduce an element of unpredictability and excitement into the game, which keeps players engaged. This criterion encourages players to remain at the table longer, especially during rounds when the dealer is close to achieving a qualifying event. Additionally, the feature may increase betting activity as players respond to the anticipation of the dealer-triggered jackpot.

### Example Walk-Through Scenario:

At a blackjack table, players are seated with a live dealer. The system is configured to activate the Mystery Jackpot when the dealer hits a perfect 21. Throughout the game, players place their bets and watch as the dealer's hand unfolds. After several rounds without a qualifying event, the dealer finally hits a perfect 21 during a tense game. The moment the dealer's hand is revealed, the system activates the Mystery Jackpot, and all players at the table are notified.

The atmosphere at the table becomes electric as players rush to place their side bets for the jackpot. Over the next few rounds, excitement builds as players hope to win the jackpot while it's still active. Once the dealer change occurs, the system deactivates the jackpot feature, resetting the conditions for the next activation.

### Example System Procedural Flow:

1. Dealer Action Monitoring: The casino's central server tracks the dealer's performance in real-time. It monitors notable outcomes, such as specific hand values or win streaks, across all LDGTs.
2. Event Trigger Detection: When the dealer achieves the pre-defined event (e.g., hitting a perfect 21), the system sends a signal to the connected game terminals, activating the Mystery Jackpot.
3. Jackpot Activation: The system enables the jackpot, and players are alerted through notifications on their terminals. Players may now place side bets to participate in the jackpot.
4. Dealer Change and Feature Reset: Once the dealer is replaced or the dealer's streak ends, the system automatically disables the jackpot feature, preventing further participation until the next qualifying event.
5. Data Logging: The system logs all jackpot-related activity, including the dealer's performance and player participation, for future reporting and analysis.

### Noteworthy Aspects and Features:

Dealer-Player Interaction: This feature enhances the connection between players and the dealer, making dealer performance a shared focal point that may trigger exciting jackpot opportunities.
Unpredictability and Engagement: Players remain engaged throughout the game, knowing that any round may activate the jackpot based on the dealer's performance.
Flexible Activation Conditions: Casinos may customize the dealer-triggered event based on the game, offering a tailored experience across different table games.

### Mystery Jackpot Enabling/Disabling Criteria #8—Game Type Switching

Description and Implementation: This criterion activates the Mystery Jackpot feature when players switch between different game types (e.g., from blackjack to poker) at a multi-game ETGT or LDGT system. The casino gaming network tracks player activity across various game types, and the jackpot becomes available when a switch is detected. This functionality encourages players to explore multiple games during their session, adding variety to their experience while keeping the jackpot feature in play.

For example, a player who switches from a blackjack table to a poker game may trigger the jackpot feature as part of the game type switching mechanism. The system monitors each player's game selection, and when the switch occurs, it enables the jackpot for that player or table.

Benefits to Players: Players are incentivized to try out different game types, knowing that switching games may unlock the Mystery Jackpot. This variety adds excitement and reduces the monotony of sticking to a single game. Players may also feel that switching games offers them a new opportunity to win the jackpot, increasing their sense of control and strategy in the gaming experience.

Benefits to Casinos: Casinos benefit by promoting the use of multiple games, increasing player engagement across different table types. By encouraging players to switch games, casinos may optimize the use of their ETGTs and LDGTs, distributing player traffic more evenly across available games. Additionally, the system fosters longer play sessions, as players remain motivated to continue switching games in search of jackpot opportunities.

### Example Walk-Through Scenario:

At an ETGT terminal, Mark is playing blackjack and enjoying a steady winning streak. However, he notices that the Mystery Jackpot feature is advertised for players who switch games. After a few more hands, he decides to switch to poker, knowing that the jackpot will be activated upon making the switch. As soon as he selects poker from the terminal's game menu, the system recognizes the game change and triggers the jackpot feature. A notification appears on his screen, informing him that the jackpot is now available.

Mark places a side bet in hopes of winning the jackpot during the next few rounds of poker. After playing several hands, he switches back to blackjack, and the system again activates the jackpot, giving him another chance to participate.

### Example System Procedural Flow:

1. Game Selection Monitoring: The casino system continuously tracks player game selections across all ETGTs and LDGTs. When a player switches between games, the system logs the activity.
2. Game Switch Detection: When a player selects a new game type, the system identifies the switch and sends a signal to activate the Mystery Jackpot feature for that player or table.
3. Jackpot Activation: The jackpot feature is enabled, and players are notified. They may place side bets to participate in the jackpot during the newly selected game.
4. Game-Specific Jackpot Rules: The system adjusts the jackpot rules based on the new game type, ensuring that the criteria for winning the jackpot align with the game being played.
5. Switch Logging and Data Processing: The system logs all game switches and tracks player participation in the jackpot across multiple game types. This data is used to generate reports for casino management.

### Noteworthy Aspects and Features:

Encourages Game Variety: By linking the jackpot feature to game switching, the system promotes the exploration of different game types, enhancing the overall gaming experience.
Extended Play Sessions: Players are incentivized to continue switching games, leading to longer play sessions and increased engagement across multiple games.
Dynamic and Flexible System: The ability to activate the jackpot across different game types makes the system versatile, offering a tailored experience depending on the game being played.

### Mystery Jackpot Enabling/Disabling Criteria #9—Player-Specific Enabling

Description and Implementation: This criterion enables the Mystery Jackpot feature exclusively for players who meet specific criteria, such as loyalty tier (e.g., VIP status), cumulative playtime, or wager history. The system tracks each player's profile and gaming history, and the jackpot feature is unlocked only for players who meet the defined conditions. The casino network integrates with player tracking systems to monitor eligibility in real-time.

For instance, a VIP player who has reached a certain tier in the casino's loyalty program may automatically qualify for exclusive access to the Mystery Jackpot. This feature adds a layer of personalization, ensuring that the most valuable or loyal players have unique opportunities to win.

Benefits to Players: Players who meet the criteria for jackpot access feel recognized and rewarded for their loyalty or high-level play. This personalized treatment enhances the overall gaming experience, making players feel valued. VIP players, in particular, enjoy exclusive access to jackpots that are not available to others, adding prestige and excitement to their gaming sessions.

Benefits to Casinos: Casinos may use this feature to reward their most loyal or high-spending customers, strengthening player retention and encouraging continued patronage. By offering exclusive jackpots to select players, casinos may build stronger relationships with their VIP clientele, leading to increased long-term loyalty. Additionally, the personalized nature of the feature ensures that the casino's rewards program remains competitive and appealing to high-value players.

### Example Walk-Through Scenario:

At an LDGT, a VIP player named Sarah is participating in a high-stakes baccarat game. The system, recognizing her VIP status based on her loyalty tier, automatically activates the Mystery Jackpot feature for her. A notification appears on her screen, informing her that she has exclusive access to the jackpot due to her VIP status.

Other players at the table notice the notification but do not have access to the jackpot, as they do not meet the criteria. Sarah places a side bet to enter the jackpot, knowing that her VIP status gives her a unique advantage in the game. Throughout the session, Sarah continues to enjoy the exclusive feature, which adds to her overall experience at the casino.

### Example System Procedural Flow:

1. Player Profile Monitoring: The casino system continuously tracks player profiles, including loyalty status, playtime, and wager history, through integrated player tracking systems.
2. Eligibility Check: When a player logs into the game, the system checks if they meet the criteria for the Mystery Jackpot feature. If they qualify (e.g., VIP status), the jackpot is activated for that player.
3. Exclusive Jackpot Activation: The eligible player receives a notification that the jackpot is now available. Only players who meet the criteria are able to participate in the jackpot.
4. Player Interaction and Bets: The system logs all player interactions with the jackpot, including side bets and jackpot participation. The jackpot remains active for the player as long as they meet the qualifying criteria.
5. Data Logging and Reporting: The system logs all jackpot activity, generating reports for casino management that detail player participation and jackpot performance.

### Noteworthy Aspects and Features:

Exclusive Access for VIPs: This feature offers a personalized experience for high-value players, rewarding their loyalty and encouraging continued engagement with the casino.
Player Recognition: By linking the jackpot to specific player criteria, casinos may acknowledge and reward players for their long-term commitment or high spending levels.
Real-Time Eligibility Monitoring: The system dynamically tracks player profiles and adjusts jackpot eligibility in real-time, ensuring that only qualifying players have access to the exclusive feature.

### Mystery Jackpot Enabling/Disabling Criteria #10—Holiday or Event Promotion

Description and Implementation: This enabling criterion ties the Mystery Jackpot feature to specific holidays or casino-wide promotional events, such as New Year's Eve, a casino anniversary, or themed nights. The casino's management may schedule these events in advance, and the jackpot is only available during the duration of the event. The implementation involves the casino gaming network, which activates the jackpot feature across all LDGTs (Live Dealer Game Tables) and ETGTs (Electronic Table Game Terminals) when the designated holiday or event begins.

For example, during a New Year's Eve celebration, the system automatically activates the Mystery Jackpot feature across all connected terminals at a specific time (e.g., 10:00 PM), giving players a limited-time opportunity to participate. This feature may include enhanced jackpot payouts or special side-bet options to increase player excitement during the event.

Benefits to Players: Players enjoy one aspect of novelty and excitement of special event jackpots, which often come with enhanced prize pools or unique game features. The alignment with holidays or events creates a festive atmosphere that heightens the gaming experience. Players feel that they are part of a larger celebration, and the limited-time nature of the event encourages them to participate immediately.

Benefits to Casinos: Casinos may capitalize on holidays and promotional events to draw more patrons to the gaming floor. These special jackpots create a sense of urgency and exclusivity, which encourages players to attend during the event and remain engaged for longer periods. Promotions tied to specific dates also give casinos a unique marketing angle to attract new and returning players. Additionally, by offering enhanced jackpots during these events, casinos may increase player activity and overall wager volume.

### Example Walk-Through Scenario:

On the night of New Year's Eve, the casino is hosting a special celebration for its patrons. At exactly 10:00 PM, the casino management activates the Mystery Jackpot feature across all ETGTs and LDGTs, announcing the start of a special jackpot promotion for the night. Players at various tables receive notifications on their screens, informing them that the jackpot is live and will remain available until midnight.

Players who were already planning to gamble for the evening are now incentivized to place higher bets or participate in side bets for a chance to win the special event jackpot. The atmosphere in the casino becomes electric as more players join the tables, hoping to claim the enhanced prize before the event ends. As the clock nears midnight, one lucky player hits the jackpot, and the crowd erupts in excitement. After the event, the system disables the jackpot feature until the next scheduled promotion.

### Example System Procedural Flow:

1. Event Scheduling: The casino's management schedules the holiday or promotional event through the central server, setting the start and end times for the Mystery Jackpot activation.
2. System Notification and Activation: When the event begins, the casino system sends a signal to all connected ETGTs and LDGTs, activating the jackpot feature across the gaming floor. Players are notified via on-screen messages and audio cues.
3. Player Participation: Players who are already seated may now place side bets to participate in the event-specific jackpot. New players joining the game are also eligible, as long as the event is ongoing.
4. Event-End and Jackpot Deactivation: Once the event concludes (e.g., midnight), the system automatically disables the jackpot feature, and any remaining jackpot pool is preserved for future events or reset as per casino policies.
5. Event Logging and Reporting: The system logs all jackpot activity during the event, tracking player participation, bet volumes, and jackpot payouts for future analysis by the casino management.

### Noteworthy Aspects and Features:

Event-Driven Excitement: This feature leverages holidays and promotions to create excitement and drive player participation during specific times, enhancing the overall gaming experience.
Enhanced Payout Opportunities: Casinos may offer larger or enhanced jackpots during these events, which may attract more high-stakes players.
Marketing and Engagement: The combination of holiday excitement and exclusive jackpots serves as a powerful marketing tool, encouraging both new and returning players to visit the casino during special events.

### Mystery Jackpot Enabling/Disabling Criteria #11—Special Bet Combination

Description and Implementation: This enabling criterion activates the Mystery Jackpot feature when a player places a specific combination of bets, such as a combination of side bets and main bets. The jackpot becomes available only when the player places a qualifying bet pattern, which is predefined by the casino. The system monitors each player's betting behavior in real-time, triggering the jackpot eligibility when the required bet combination is met.

For instance, in a blackjack game, the player may be required to place a side bet of $50 along with a main bet of $200. Once this specific bet combination is placed, the Mystery Jackpot is activated for that player, and they are eligible for the jackpot payout if certain conditions are met during the game.

Benefits to Players: Players are encouraged to explore new betting strategies and combinations, adding complexity and excitement to their gameplay. The opportunity to unlock the Mystery Jackpot through a specific bet combination adds an element of skill and choice, allowing players to feel more in control of their gaming experience. Players also appreciate the potential for higher payouts when they place larger or more strategic bets.

Benefits to Casinos: Casinos benefit by encouraging players to place higher-value bets or side bets in conjunction with their regular wagers. This increases the overall wager volume and leads to larger jackpot pools. The specific bet combinations may also be used to introduce new side bet options, adding variety to the gaming experience and increasing player engagement. By incentivizing specific bet combinations, casinos may influence player behavior in a way that maximizes revenue while enhancing the gaming experience.

### Example Walk-Through Scenario:

Jane, an experienced baccarat player, notices a promotional banner indicating that placing a special combination of bets may unlock the Mystery Jackpot. Intrigued, she decides to place a side bet of $50 and a main bet of $300, as outlined in the promotion. The system recognizes her qualifying bet combination and triggers the Mystery Jackpot for her game. Jane receives a notification on her screen, indicating that she is now eligible for the jackpot based on her bet pattern.

Over the next few rounds, Jane continues placing the required combination of bets, knowing that she may win the jackpot if the conditions align in her favor. Other players at the table notice her strategy and begin placing similar combinations, hoping to also unlock the jackpot. After several rounds, the jackpot is triggered, and Jane wins a significant payout. The system logs her win, and the jackpot is reset for future play.

### Example System Procedural Flow:

1. Bet Monitoring: The system tracks all bets placed by players at the table, identifying patterns that match the predefined qualifying combination (e.g., side bet+main bet).
2. Bet Combination Detection: When a player places the specific combination of bets, the system recognizes the qualifying pattern and activates the Mystery Jackpot for that player. A notification is sent to the player's terminal.
3. Player Interaction: Once the jackpot is active, the player may continue placing the qualifying bet combination in subsequent rounds to increase their chances of winning the jackpot.
4. Jackpot Payout: If the player wins the jackpot, the system calculates the payout and deducts the amount from the jackpot pool. The jackpot is then reset for the next eligible player or combination.
5. Data Logging and Reporting: All bet patterns, player interactions, and jackpot outcomes are logged by the system, allowing casino management to analyze betting behavior and jackpot performance.

### Noteworthy Aspects and Features:

Strategic Betting: This feature adds a strategic element to gameplay, encouraging players to think carefully about their bet combinations to unlock the jackpot.
Increased Bet Volume: By requiring players to place higher-value or multiple bets, casinos may significantly increase wager volumes and overall revenue.
Customizable Bet Combinations: Casinos have the flexibility to define different qualifying bet combinations, which may be tailored to specific games or player demographics, offering a unique and varied experience.

### Mystery Jackpot Enabling/Disabling Criteria #12—Dealer Win Streak

Description and Implementation: This enabling criterion activates the Mystery Jackpot when the dealer achieves a specific number of consecutive wins (e.g., five wins in a row). The system tracks the dealer's performance in real-time, and once the required win streak is reached, the jackpot becomes available to all players at the table. The feature creates a dynamic interaction between the dealer's success and the players' chances to win the jackpot.

For example, in a blackjack game, the dealer may need to win five consecutive rounds before the Mystery Jackpot is activated. Once the dealer hits this win streak, all players at the table become eligible for the jackpot, creating an added layer of excitement.

Benefits to Players: Players are engaged by the dealer's performance, as they benefit directly from the dealer's success. This criterion adds a unique twist to traditional table games, where the dealer's performance may lead to substantial rewards for the players. The interaction between dealer outcomes and player rewards enhances the social and competitive aspects of the game.

Benefits to Casinos: Casinos benefit from increased player retention and engagement, as players are to stay at the table to see if the dealer reaches the required win streak. This feature encourages longer play sessions, as players become invested in the dealer's performance. Additionally, the unpredictability of when the jackpot will be activated adds suspense, driving higher bet volumes as players hope to capitalize on the dealer's win streak.

### Example Walk-Through Scenario:

At a blackjack table, the dealer has just won two consecutive rounds, and the players are beginning to notice. The system is configured to activate the Mystery Jackpot after five dealer wins in a row. The players at the table start placing larger bets, hoping to benefit from the dealer's streak and trigger the jackpot.

After a few more rounds, the dealer secures their fifth consecutive win, and the system activates the Mystery Jackpot. All players at the table are notified, and they quickly place side bets to participate in the jackpot. The excitement builds as the jackpot pool continues to grow with each bet. Eventually, one of the players wins the jackpot, and the dealer's win streak is reset for the next round of play.

### Example System Procedural Flow:

1. Dealer Performance Monitoring: The system tracks each round of play, logging the dealer's wins and losses in real-time.
2. Win Streak Detection: Once the dealer achieves the specified number of consecutive wins (e.g., five), the system sends a signal to activate the Mystery Jackpot.
3. Jackpot Activation: The jackpot feature is activated for all players at the table, allowing them to place side bets to participate in the jackpot.
4. Player Interaction: Players may continue placing bets during the active jackpot period, and the system logs all contributions to the jackpot pool.
5. Post-Streak Reset: After the jackpot is won or the dealer's win streak is broken, the system resets the dealer's win count, and the jackpot feature is disabled until the next qualifying streak.

### Noteworthy Aspects and Features:

Dealer-Driven Excitement: This feature creates a direct connection between the dealer's performance and the players' chances of winning, enhancing the social dynamics of the game.
Longer Play Sessions: Players are to stay longer at the table, hoping to see the dealer reach the required win streak and activate the jackpot.
Dynamic Gameplay: The unpredictability of the dealer's win streak adds suspense to the game, keeping players engaged and motivated to continue betting.

### Mystery Jackpot Enabling/Disabling Criteria #13—Casino-Wide Progressive Jackpot

Description and Implementation: This enabling criterion is tied to a casino-wide progressive jackpot, where the jackpot pool grows based on bets placed across all connected LDGTs and ETGTs in the casino. The Mystery Jackpot becomes available when the progressive jackpot reaches a predefined threshold (e.g., $100,000). This feature allows all players in the casino to contribute to and potentially win a shared jackpot, creating a sense of community and excitement.

The casino network tracks all contributions to the progressive jackpot, and once the pool reaches the required amount, the Mystery Jackpot feature is activated across all connected terminals. Players at any participating table may then place side bets for a chance to win the progressive jackpot.

Benefits to Players: Players benefit from the large prize pools that may accumulate quickly in a casino-wide progressive jackpot system. The opportunity to win a substantial prize adds excitement to every bet, and the shared nature of the jackpot fosters a sense of camaraderie among players. The transparency of the growing jackpot pool also keeps players engaged, as they watch the potential prize increase over time.

Benefits to Casinos: Casinos benefit from increased player engagement across all games, as every player contributes to the growing jackpot pool. The progressive nature of the jackpot encourages longer play sessions, as players are motivated to stay and watch the pool grow. Additionally, the large prize pool may attract more high-stakes players, leading to higher overall wager volumes. The casino may also promote the progressive jackpot as a notable feature, drawing in more patrons.

### Example Walk-Through Scenario:

Throughout the day, players across the casino are contributing to the progressive jackpot by placing side bets at various LDGTs and ETGTs. As the pool grows, the casino displays the current jackpot amount on large screens across the gaming floor, building anticipation among the players. By the evening, the jackpot pool has reached $100,000, triggering the activation of the Mystery Jackpot feature.

Players at multiple tables receive notifications that the progressive jackpot is now live, and they quickly begin placing side bets for a chance to win. Over the next hour, the casino is buzzing with excitement as players watch the jackpot pool grow even larger with each bet. Finally, one lucky player at a baccarat table hits the jackpot, winning the massive prize to the cheers of other players.

### Example System Procedural Flow:

1. Progressive Jackpot Monitoring: The casino network continuously tracks all bets placed at participating LDGTs and ETGTs, contributing a portion of each bet to the progressive jackpot pool.
2. Threshold Detection: When the progressive jackpot pool reaches the predefined threshold (e.g., $100,000), the system activates the Mystery Jackpot feature across all connected terminals.
3. Jackpot Activation: Players are notified that the progressive jackpot is now live, and they may place side bets to participate in the jackpot.
4. Player Interaction and Contributions: The system logs all player contributions to the jackpot pool, displaying the growing pool amount on screens throughout the casino.
5. Jackpot Payout: When a player wins the progressive jackpot, the system calculates the payout and resets the pool to its base value. The process then begins again as players continue contributing to the new pool.

### Noteworthy Aspects and Features:

Shared Jackpot Experience: The progressive nature of this jackpot creates a sense of community among players, as everyone contributes to the growing prize pool.
Large Prize Pools: The ability to accumulate a large jackpot pool attracts more players and encourages higher-stakes betting.
Casino-Wide Excitement: The shared excitement of watching the progressive jackpot grow keeps players engaged and invested in the outcome, driving longer play sessions and higher bet volumes.

### Mystery Jackpot Enabling/Disabling Criteria #14—High Wager Volume Over Time

Description and Implementation: This enabling criterion activates the Mystery Jackpot feature when a player's cumulative wager volume over a set period (e.g., one hour or one gaming session) surpasses a predefined threshold. The system tracks each player's bet amounts across multiple rounds or games, continuously updating their total wager volume. Once the threshold is met, the jackpot becomes available to that player, creating an exclusive opportunity to win.

For instance, a casino may set the threshold at $10,000 wagered within a single session. Players who reach this amount are automatically eligible for the Mystery Jackpot, which may remain active for a limited period (e.g., 10 minutes after activation). This system encourages high-volume betting, as players see a clear path to unlocking the jackpot through cumulative wagering.

Benefits to Players: Players are incentivized to increase their betting volume to unlock the Mystery Jackpot. The cumulative nature of the criterion gives players the freedom to spread their bets across multiple rounds or games, making the target feel achievable. This system provides an additional layer of excitement and reward for players who are already committed to betting larger amounts, offering them a tangible goal to work towards during their session.

Benefits to Casinos: Casinos benefit from the increased wagering activity, as players are motivated to place larger bets or play more frequently to meet the threshold. The criterion also extends playtime, as players may continue betting longer to accumulate the required wager volume. By rewarding high-volume players with exclusive access to the jackpot, casinos may foster loyalty among their most valuable patrons while driving higher overall revenue.

### Example Walk-Through Scenario:

David, a regular baccarat player, has been placing a steady stream of $500 bets throughout his gaming session. As the session progresses, the system tracks his total wager volume, updating his cumulative amount after each round. David is aware that once he reaches the $10,000 threshold, he will qualify for the Mystery Jackpot.

After about an hour of play, David places another large bet, pushing his total wager volume over the threshold. A notification immediately appears on his ETGT screen, informing him that the Mystery Jackpot is now active for him. Excited, David places a side bet on the jackpot for the next round. The system tracks his participation, and after several high-stakes rounds, David wins the jackpot. The system resets his wager volume, and the process begins again.

### Example System Procedural Flow:

1. Cumulative Wager Tracking: The casino system tracks the total wager volume for each player across all LDGTs and ETGTs, updating their cumulative wager amount after every round.
2. Threshold Detection: When a player's total wager volume reaches the predefined threshold (e.g., $10,000), the system triggers the activation of the Mystery Jackpot for that player. A notification is displayed on the player's terminal.
3. Jackpot Activation: The Mystery Jackpot becomes available for the player, allowing them to place side bets and participate in the jackpot.
4. Player Interaction: The system tracks the player's participation in the jackpot, logging all side bets and contributions to the jackpot pool.
5. Session Reset: Once the player wins the jackpot or the session ends, the system resets the cumulative wager count, and the player must start accumulating wagers again to qualify for future jackpots.

### Noteworthy Aspects and Features:

Encourages Higher Betting Volume: This criterion motivates players to increase their betting volume over time, contributing to larger jackpots and higher revenue for the casino.

Cumulative Betting Flexibility: Players may accumulate wagers across multiple rounds or games, making the threshold feel more achievable and maintaining engagement over a longer period.
Exclusive Player Reward: By offering the jackpot only to players who meet the wager volume requirement, the system creates an exclusive and personalized gaming experience.

### Mystery Jackpot Enabling/Disabling Criteria #15—Specific Game Outcome Trigger

Description and Implementation: This enabling criterion activates the Mystery Jackpot feature when a specific game outcome occurs, such as a rare hand in poker, a tie in baccarat, or a specific card combination in blackjack. The casino's system monitors game outcomes in real-time, and when the defined event happens, the jackpot feature is triggered for all players at the table or specific players who contributed to the event. This adds an element of unpredictability, as players are incentivized to bet on less common outcomes in hopes of triggering the jackpot.

For example, in baccarat, the Mystery Jackpot may be triggered when a rare tie occurs. The system identifies the outcome and immediately activates the jackpot, allowing players who bet on that event or who are present at the table to participate.

Benefits to Players: Players enjoy the excitement of rare, unexpected events that may lead to significant rewards. The possibility of triggering the jackpot through a unique game outcome adds an extra layer of suspense to each round, keeping players engaged. Additionally, players who successfully bet on rare outcomes feel a sense of accomplishment and are rewarded with access to the jackpot, enhancing the overall thrill of the game.

Benefits to Casinos: Casinos benefit from increased bet diversity, as players are more to place side bets or wager on less common outcomes in hopes of triggering the jackpot. This diversification of bets may lead to higher overall wager volumes and larger jackpot pools. The unpredictability of the outcome-based trigger also keeps players engaged for longer periods, as any round may potentially lead to the activation of the jackpot.

### Example Walk-Through Scenario:

During a baccarat game at an LDGT, players are placing their usual bets on the banker or player outcomes. However, one player, Jessica, decides to place a bet on a tie, knowing that the Mystery Jackpot will be triggered if the rare outcome occurs. The game proceeds, and to Jessica's surprise, the cards reveal a tie. The system immediately recognizes the rare outcome and activates the Mystery Jackpot for all players at the table.

Excitement builds as players, including Jessica, place side bets on the jackpot for the next round. The jackpot pool grows rapidly, fueled by the sudden activation. After several rounds of intense gameplay, one player wins the jackpot, and the system resets the feature for future games.

### Example System Procedural Flow:

1. Outcome Monitoring: The casino system continuously monitors game outcomes at all LDGTs and ETGTs, logging each result in real-time.
2. Specific Outcome Detection: When a predefined rare outcome occurs (e.g., a tie in baccarat), the system triggers the activation of the Mystery Jackpot for all eligible players.
3. Jackpot Activation: The Mystery Jackpot becomes available, and players are notified via on-screen messages.

They may place side bets to participate in the jackpot.
4. Player Participation and Jackpot Payout: The system tracks all player participation, side bets, and contributions to the jackpot pool. Once the jackpot is won, the system disburses the payout and resets the feature.
5. Outcome Logging: All game outcomes, player interactions, and jackpot activity are logged by the system, providing detailed data for casino management.

### Noteworthy Aspects and Features:

Rare Event Excitement: Players are incentivized to bet on rare outcomes, adding a layer of excitement and unpredictability to the game.
Diversified Betting Options: The criterion encourages players to place bets on a wider range of outcomes, increasing overall wager diversity and potential jackpot contributions.
Unpredictable Jackpot Activation: The randomness of when the jackpot will be triggered keeps players engaged, as any round may lead to a jackpot opportunity.

### Mystery Jackpot Enabling/Disabling Criteria #16—Player Win/Loss Ratio

Description and Implementation: This criterion activates the Mystery Jackpot feature when a player's win/loss ratio reaches a predefined level, either in favor of wins or losses. The system continuously tracks each player's performance throughout the gaming session, calculating their win/loss ratio after every round. When the ratio meets the specified condition (e.g., 70% wins or 70% losses), the jackpot is triggered for that player, creating an opportunity for them to participate.

For instance, in a blackjack game, if a player achieves a win ratio of 70% over the course of 20 rounds, the system recognizes this performance and activates the Mystery Jackpot, offering the player a chance to win a significant reward based on their streak.

Benefits to Players: Players are rewarded for either sustained success or continued participation despite a losing streak. This feature enhances the gaming experience by acknowledging both positive and negative performance, giving players additional motivation to continue playing. The opportunity to unlock the jackpot through their win/loss ratio adds excitement and encourages players to stay engaged, regardless of whether they are winning or losing.

Benefits to Casinos: Casinos benefit from increased player retention, as players are motivated to keep playing to either improve their win ratio or recover from a losing streak. This feature encourages longer play sessions and higher wager volumes, as players try to reach the required ratio to trigger the jackpot. Additionally, casinos may balance their jackpot payouts by rewarding both winning and losing players, ensuring consistent engagement across the gaming floor.

### Example Walk-Through Scenario:

Kevin is playing blackjack at an ETGT and has been on a hot streak, winning 70% of the rounds over the past hour. As the system tracks his performance, it calculates his win/loss ratio in real-time. After winning another round, Kevin's ratio reaches the predefined threshold of 70% wins, and the system immediately activates the Mystery Jackpot for him.

Kevin receives a notification on his screen, informing him that his win ratio has unlocked the jackpot. He places a side bet to participate in the jackpot for the next round. After several rounds of high-stakes gameplay, Kevin wins the jackpot, and the system resets his win/loss ratio for future play.

### Example System Procedural Flow:

1. Performance Tracking: The casino system tracks each player's win/loss ratio in real-time, updating the ratio after every round.
2. Ratio Detection: When a player's win/loss ratio reaches the predefined threshold (e.g., 70% wins), the system triggers the activation of the Mystery Jackpot for that player.
3. Jackpot Activation: The player is notified that the jackpot is now available, and they may place side bets to participate.
4. Player Interaction: The system tracks the player's participation in the jackpot, logging all side bets and contributions to the jackpot pool.
5. Post-Activation Reset: After the player wins the jackpot or the session ends, the system resets the player's win/loss ratio, and they must start accumulating new rounds to qualify again.

### Noteworthy Aspects and Features:

Performance-Based Reward: This criterion acknowledges both winning and losing streaks, ensuring that players feel rewarded regardless of their current performance.
Real-Time Tracking: The system continuously updates the player's win/loss ratio, creating a dynamic and responsive gaming experience.
Extended Engagement: Players are motivated to continue playing, either to maintain a winning streak or recover from losses, driving longer sessions and higher wager volumes.

### Mystery Jackpot Enabling/Disabling Criteria #17—Multi-Table Contribution

Description and Implementation: This enabling criterion activates the Mystery Jackpot when players across multiple tables contribute to a shared jackpot pool. The system aggregates bets placed at all connected LDGTs and ETGTs, and once the collective contributions reach a certain threshold, the jackpot becomes available to all participating players. This criterion encourages cross-table engagement and fosters a sense of community among players, as everyone contributes to a single, shared jackpot.

For example, in a casino with multiple baccarat tables, the system tracks the contributions from each table's side bets. Once the total amount across all tables reaches a predefined amount (e.g., $50,000), the Mystery Jackpot is triggered, allowing players at all participating tables to compete for the prize.

Benefits to Players: Players benefit from the shared nature of the jackpot, as they feel part of a larger community working together to unlock a significant prize. The collective contributions add excitement to every round, as players see the jackpot pool grow with each bet. Additionally, the large prize pool resulting from multi-table contributions creates a more thrilling and rewarding experience.

Benefits to Casinos: Casinos benefit from increased overall wager volumes, as multiple tables contribute to a single jackpot pool. This criterion drives higher engagement across the gaming floor, as players at different tables are incentivized to place side bets in the hope of triggering the shared jackpot. The larger prize pool also attracts more players to participate, increasing player traffic and bet frequency.

### Example Walk-Through Scenario:

In a busy casino, players are seated at several baccarat tables, each contributing side bets to the same Mystery Jackpot pool. As the game progresses, the system tracks the contributions from each table, displaying the growing jackpot amount on screens across the gaming floor. Players at all tables are aware that once the pool reaches $50,000, the jackpot will be activated for everyone.

After several high-stakes rounds, the jackpot pool reaches the required threshold, and the system activates the Mystery Jackpot feature for all connected tables. Players at each table place side bets, hoping to claim the prize. After a few more rounds, one player wins the jackpot, and the system resets the pool for future contributions.

### Example System Procedural Flow:

1. Multi-Table Contribution Tracking: The casino system aggregates contributions from all connected LDGTs and ETGTs, updating the total jackpot pool in real-time.
2. Threshold Detection: Once the total contributions reach the predefined threshold (e.g., $50,000), the system triggers the activation of the Mystery Jackpot for all participating tables.
3. Jackpot Activation: The jackpot becomes available, and players at all contributing tables are notified. They may place side bets to participate in the jackpot.
4. Cross-Table Player Interaction: The system logs all player participation and contributions to the jackpot pool, ensuring that all eligible players have a chance to win.
5. Jackpot Payout and Pool Reset: When the jackpot is won, the system calculates the payout and resets the pool for future contributions from all connected tables.

### Noteworthy Aspects and Features:

Shared Jackpot Pool: This feature creates a sense of community among players, as everyone contributes to and competes for the same jackpot, regardless of their table.
Increased Wager Volume: By pooling contributions from multiple tables, casinos may accumulate larger jackpots more quickly, driving higher overall wager volumes.
Casino-Wide Engagement: The shared nature of the jackpot encourages engagement across multiple tables, creating a unified gaming experience for all players involved.

### Mystery Jackpot Enabling/Disabling Criteria #18—Special Event-Based Activation

Description and Implementation: This criterion enables the Mystery Jackpot feature during special casino-wide events, such as tournaments, celebrity appearances, or grand openings. These events may be predetermined or occur spontaneously, and the Mystery Jackpot becomes available only during the specified event timeframe. The casino network system coordinates with its LDGTs (Live Dealer Game Tables) and ETGTs (Electronic Table Game Terminals) to activate the jackpot when the event begins and automatically disables it when the event ends.

For example, during a high-profile poker tournament, the Mystery Jackpot may be enabled across all ETGTs, allowing players to place side bets for a chance to win an event-specific jackpot. The activation may be tied to the event's theme or feature special prizes, such as increased payouts or promotional bonuses.

Benefits to Players: Players are drawn to the unique opportunities that event-based jackpots offer. The connection to special occasions makes gameplay more exciting and memorable, particularly when combined with exclusive rewards or bonuses. Players may feel a heightened sense of occasion during these events, motivating them to participate more actively. Additionally, players benefit from the limited-time nature of the jackpot, creating urgency to join the action while the event is ongoing.

Benefits to Casinos: Casinos may use this criterion to drive attendance and participation during high-traffic events, creating a lively atmosphere that encourages longer play sessions and higher wager volumes. By linking the jackpot to special events, casinos may market the experience as an exclusive and time-sensitive opportunity, drawing in both regular patrons and new players. The event-based activation may also serve as a valuable promotional tool, helping to boost overall foot traffic and excitement on the gaming floor.

### Example Walk-Through Scenario:

A major poker tournament is taking place at the casino, and management has decided to activate the Mystery Jackpot across all connected ETGTs as part of the event. Players at different tables receive notifications on their screens, informing them that the event-based Mystery Jackpot is live and will be available for the duration of the tournament.

Tom, a regular player, decides to join in on the action by placing a side bet on the jackpot while playing blackjack. As the tournament progresses, the jackpot pool grows as more players participate. The excitement on the gaming floor builds, and Tom places larger side bets to increase his chances of winning. Toward the end of the event, Tom hits the jackpot, winning an enhanced prize, which adds to the overall celebration of the tournament.

### Example System Procedural Flow:

1. Event Scheduling: The casino management schedules the special event and sets the timeframe for the Mystery Jackpot activation. The system prepares all connected LDGTs and ETGTs for synchronized activation.
2. Jackpot Activation at Event Start: Once the event begins, the system sends a signal to activate the Mystery Jackpot feature across all participating terminals. Players are notified via on-screen messages and promotional displays around the casino.
3. Player Participation: Players at any participating table may place side bets on the Mystery Jackpot. The system tracks all contributions and updates the jackpot pool in real-time.
4. Event Monitoring and Ongoing Play: The system continues to monitor player activity throughout the event, ensuring that the jackpot remains active for the duration of the event. Players who join mid-event may also participate in the jackpot.
5. Event End and Jackpot Deactivation: When the event concludes, the system automatically disables the Mystery Jackpot feature and finalizes any pending payouts. The pool resets for future events or regular gameplay.

### Noteworthy Aspects and Features:

Timed Exclusivity: The event-based activation creates a sense of exclusivity and urgency, driving increased player engagement during special occasions.
Promotional Flexibility: Casinos may use this feature to promote a variety of events, from tournaments to holiday celebrations, offering tailored jackpots for different themes.
Enhanced Player Experience: The connection between the jackpot and special events creates an exciting, immersive gaming experience that encourages players to stay longer and bet more.
   Mystery Jackpot Enabling/Disabling Criteria #19—Achieving a Certain hand in Card Games

Description and Implementation: This enabling criterion activates the Mystery Jackpot when a player achieves a specific hand or combination in a card game, such as blackjack, poker, or baccarat. The system continuously monitors the outcomes of each hand in real-time, and when a player achieves the predefined combination (e.g., a royal flush in poker or a natural blackjack), the Mystery Jackpot is triggered. The jackpot may be made available only to the player who achieved the hand or to all players at the table, depending on the casino's configuration.

For instance, in a blackjack game, if a player hits a perfect hand with a value of 21, the Mystery Jackpot may be activated, allowing the player to place a side bet for a chance to win the jackpot. This feature adds excitement to every hand, as players are incentivized to aim for specific, high-value combinations.

Benefits to Players: Players experience heightened excitement and engagement when their skill or luck leads to a rare and valuable hand. The opportunity to unlock the jackpot through a specific hand adds an extra layer of strategy and anticipation to the game. Players are also rewarded for their success with the chance to win a significant jackpot, making the achievement of a rare hand even more rewarding.

Benefits to Casinos: Casinos benefit from the increased player focus and engagement, as players strive to achieve the specific hand required to activate the jackpot. This criterion also encourages higher betting volumes, as players are to increase their wagers when they feel close to achieving the winning hand. By offering the jackpot as a reward for rare hands, casinos may create memorable gaming experiences that encourage repeat visits and longer play sessions.

### Example Walk-Through Scenario:

In a poker game at an ETGT, several players are competing in a high-stakes round. One of the players, Sarah, manages to achieve a royal flush, one of the rarest hands in the game. As soon as the hand is revealed, the system recognizes the combination and activates the Mystery Jackpot. A notification appears on Sarah's screen, informing her that she is now eligible for the jackpot.

Excited by her achievement, Sarah places a side bet on the jackpot for the next round. The other players, impressed by her royal flush, also increase their bets, hoping to achieve similar results and unlock the jackpot for themselves. After several rounds of play, Sarah wins the jackpot, adding to her already impressive poker win.

### Example System Procedural Flow:

1. Hand Monitoring: The system continuously monitors each player's hands in real-time, tracking outcomes at all LDGTs and ETGTs.
2. Combination Detection: When a player achieves the predefined hand or combination (e.g., a royal flush), the system triggers the activation of the Mystery Jackpot for that player or table.
3. Jackpot Activation: The player is notified that the jackpot is now active, and they may place side bets to participate in the jackpot.
4. Player Participation: The system logs all side bets and contributions to the jackpot pool. Other players at the table may also participate, depending on the casino's configuration.
5. Jackpot Payout and Reset: Once the jackpot is won, the system calculates the payout and resets the pool for future rounds or hands.

### Noteworthy Aspects and Features:

Skill-Based Reward: This criterion rewards players for achieving rare hands or combinations, adding a strategic element to the game.
Heightened Engagement: Players are incentivized to play more hands and increase their bets in pursuit of the specific hand that activates the jackpot.
Real-Time Monitoring: The system's ability to track hands in real-time ensures that the jackpot is activated only when the qualifying condition is met, creating a fair and transparent gaming experience.

### Mystery Jackpot Enabling/Disabling Criteria #20—Player Reaching a Loyalty Milestone

Description and Implementation: This criterion activates the Mystery Jackpot when a player reaches a specific loyalty milestone, such as advancing to a new tier in the casino's loyalty program, accumulating a set number of loyalty points, or achieving a specific number of visits to the casino. The system integrates with the casino's player tracking and loyalty systems, monitoring each player's progress toward their milestones in real-time. Once the milestone is achieved, the Mystery Jackpot is activated for that player, offering a unique reward for their continued patronage.

For example, when a player reaches 10,000 loyalty points, the system may trigger the jackpot, allowing them to participate in the jackpot for a limited time. This feature rewards loyal players and encourages them to continue visiting the casino to achieve higher levels of rewards.

Benefits to Players: Players feel recognized and rewarded for their loyalty and continued play. The opportunity to unlock the Mystery Jackpot through their loyalty milestones adds a layer of excitement to their long-term engagement with the casino. This criterion enhances the player's overall experience by offering exclusive rewards that are tied to their ongoing participation in the loyalty program, making them feel valued.

Benefits to Casinos: Casinos benefit from increased player retention, as players are motivated to return frequently and reach higher loyalty tiers. By tying the jackpot to loyalty milestones, casinos may strengthen their relationships with valuable players, ensuring long-term engagement and repeat visits. This feature also encourages higher wager volumes, as players aim to accumulate more loyalty points or advance to the next tier.

### Example Walk-Through Scenario:

John, a regular patron of the casino, has been steadily accumulating loyalty points through his frequent visits and high-value bets. After reaching 10,000 loyalty points, the system automatically activates the Mystery Jackpot for him. A notification appears on his screen, congratulating him on his milestone and informing him that he is now eligible to participate in the jackpot.

Excited by the reward, John places a side bet on the jackpot for the next round of baccarat. His loyalty milestone has not only unlocked the jackpot but also added an extra layer of excitement to his gaming session. Over the next several rounds, John participates in the jackpot feature, and after a few lucky hands, he wins the jackpot. The system resets his loyalty progress, and John looks forward to reaching his next milestone.

### Example System Procedural Flow:

1. Loyalty Tracking: The system integrates with the casino's loyalty program, tracking each player's progress toward their milestones in real-time.
2. Milestone Detection: When a player reaches a predefined milestone (e.g., 10,000 loyalty points), the system triggers the activation of the Mystery Jackpot for that player.
3. Jackpot Activation: The player is notified that the jackpot is now active, and they may place side bets to participate.
4. Player Participation: The system logs all side bets and jackpot contributions from the player, ensuring that they have a chance to win the jackpot as a reward for their loyalty.
5. Loyalty Reset and Payout: Once the jackpot is won, the system disburses the payout and resets the player's loyalty progress for future milestones.

### Noteworthy Aspects and Features:

Loyalty-Based Reward: This feature rewards players for their long-term engagement with the casino, strengthening player loyalty and encouraging repeat visits.
Enhanced Player Experience: By tying the jackpot to loyalty milestones, the system creates a personalized and exclusive gaming experience that makes players feel valued.
Integrated Tracking: The system's integration with the casino's loyalty program ensures that the jackpot is activated fairly and transparently, based on real-time player data.

### Mystery Jackpot Enabling/Disabling Criteria 921—Player Action-Based Trigger

Description and Implementation: This criterion enables the Mystery Jackpot based on specific player actions during gameplay, such as placing a high-risk bet, doubling down in blackjack, or going all-in during a poker hand. The system monitors player actions in real-time, and when a player takes a defined high-stakes or strategic action, the jackpot is activated for them. The action-based trigger adds a dynamic element to the game, rewarding bold decisions with the opportunity to win a significant prize.

For example, in a blackjack game, if a player chooses to double down on a risky hand, the system may recognize this action and activate the Mystery Jackpot, allowing the player to place a side bet for the next round.

Benefits to Players: Players feel rewarded for making bold or high-stakes decisions, adding excitement and tension to each round. The opportunity to unlock the jackpot through their own actions gives players a greater sense of control over their gaming experience, making each decision feel more meaningful. Players who enjoy taking risks are particularly motivated by this feature, as it provides them with a direct path to potential rewards.

Benefits to Casinos: Casinos benefit from increased player engagement and higher bet volumes, as players are incentivized to take high-stakes actions to trigger the jackpot. This criterion also encourages more strategic and dynamic gameplay, as players weigh their decisions more carefully in pursuit of the jackpot. The action-based trigger creates a more exciting and fast-paced gaming environment, leading to longer play sessions and more frequent betting.

### Example Walk-Through Scenario:

During a high-stakes blackjack game, Mark faces a difficult decision. He has a total of 10 and the dealer shows a face card. Despite the risk, Mark decides to double down, hoping to beat the dealer. The system recognizes Mark's bold decision and activates the Mystery Jackpot for him. A notification appears on his screen, informing him that his action has unlocked the jackpot.

Mark places a side bet on the jackpot for the next round, excited by the possibility of winning a significant prize. His decision to double down has not only heightened the tension of the current round but also added an extra layer of excitement to his overall gameplay. After a few more rounds, Mark wins the jackpot, making his bold move even more rewarding.

### Example System Procedural Flow:

1. Action Monitoring: The system monitors player actions in real-time, tracking specific high-stakes or strategic moves such as doubling down, going all-in, or placing large bets.
2. Action Detection: When a player takes a predefined action (e.g., doubling down), the system triggers the activation of the Mystery Jackpot for that player.
3. Jackpot Activation: The player is notified that the jackpot is now active, and they may place side bets to participate in the jackpot for subsequent rounds.
4. Player Interaction: The system logs all side bets and jackpot contributions, ensuring that the player has a fair chance to win the jackpot based on their actions.
5. Payout and Reset: Once the jackpot is won, the system disburses the payout and resets the feature for future action-based triggers.

### Noteworthy Aspects and Features:

Player-Controlled Activation: This feature gives players more control over the game, rewarding them for making bold or strategic decisions.
Dynamic Gameplay: The action-based trigger creates a more exciting and fast-paced gaming environment, encouraging players to take risks and make high-stakes moves.
Higher Engagement: Players are motivated to take more frequent or larger risks, leading to longer play sessions and higher wager volumes for the casino.

### Mystery Jackpot Enabling/Disabling Criteria #22—Multiple Simultaneous Player Wins

Description and Implementation: This enabling criterion triggers the Mystery Jackpot when multiple players at a table achieve winning outcomes in the same round of play. The system monitors the outcomes for all players at LDGTs (Live Dealer Game Tables) and ETGTs (Electronic Table Game Terminals), and when two or more players win in a single round, the Mystery Jackpot is activated. This criterion adds a social and collaborative dimension to the gaming experience, as players may celebrate group success, with their collective wins unlocking a shared opportunity.

For example, at a blackjack table, if two players win their hands in the same round, the system triggers the Mystery Jackpot. All players at the table may then place side bets for a chance to win the jackpot during the next round.

Benefits to Players: Players experience an added level of excitement when their individual success coincides with the success of others at the table. The shared nature of the win creates a sense of camaraderie and increases engagement, as players are motivated to celebrate collective wins. This criterion also adds variety to the gameplay, offering a different path to unlocking the jackpot and rewarding players for being part of a lucky table.

Benefits to Casinos: Casinos benefit from increased table engagement and wager volumes, as players are incentivized to continue playing to see if multiple simultaneous wins will unlock the jackpot. This feature encourages longer play sessions, as players stay at the table in the hopes of collective success. The social element of the shared win also enhances the overall atmosphere at the table, making the game more enjoyable for all participants, which may lead to more frequent betting.

### Example Walk-Through Scenario:

During a game of blackjack at an ETGT, three players each place their bets. As the dealer reveals the cards, all three players manage to beat the dealer's hand, achieving simultaneous wins. The system instantly recognizes the multiple winning outcomes and activates the Mystery Jackpot. A notification is sent to all players at the table, informing them that the jackpot is now live.

Excitement builds as the players, encouraged by their collective success, place side bets for the jackpot in the following round. The shared win creates a celebratory atmosphere, with all players eagerly anticipating the chance to win the jackpot. After a few rounds, one of the players hits the jackpot, making the session even more thrilling for everyone involved.

### Example System Procedural Flow:

1. Outcome Monitoring: The casino system tracks the outcomes of all players' bets at LDGTs and ETGTs, recording wins and losses for each round in real-time.
2. Simultaneous Win Detection: When multiple players achieve winning outcomes in the same round (e.g., two or more players beating the dealer), the system identifies the simultaneous wins and triggers the activation of the Mystery Jackpot.
3. Jackpot Activation: The system notifies all players at the table that the jackpot is now live, allowing them to place side bets and participate in the jackpot for the next round.
4. Player Participation: The system logs all side bets and jackpot contributions from the participating players.

Players who did not win in the previous round are still eligible to place side bets and participate in the jackpot.
5. Jackpot Payout and Reset: Once the jackpot is won, the system disburses the payout and resets the feature for future rounds of simultaneous wins.

### Noteworthy Aspects and Features:

Collaborative Gameplay: This criterion adds a social element to the game, rewarding players for collective success and encouraging group celebration.
Dynamic Engagement: The shared nature of the win keeps players engaged, as they are excited by the possibility of unlocking the jackpot through group achievements.
Longer Play Sessions: Players are to stay at the table longer, anticipating multiple simultaneous wins that may activate the jackpot and provide additional rewards.

### Mystery Jackpot Enabling/Disabling Criteria #23—Game Speed or Pace Threshold

Description and Implementation: This enabling criterion triggers the Mystery Jackpot when the game is played at a specific speed or pace. The system tracks the time it takes to complete each round or game, and if the game is played within a certain timeframe (e.g., 60 seconds or less for a blackjack round), the jackpot is activated. This feature is particularly suited to fast-paced environments where players enjoy quick gameplay and rapid betting.

For example, in a baccarat game, if a full round is completed within 90 seconds, the Mystery Jackpot is triggered, rewarding players for maintaining a brisk pace. This criterion encourages fast decision-making and adds an extra level of excitement to high-energy gameplay.

Benefits to Players: Players who enjoy fast-paced gaming are rewarded for their quick decisions and participation in a more dynamic gaming environment. The opportunity to unlock the jackpot based on game speed adds excitement to every round, keeping players focused and engaged. Fast-paced gameplay also allows players to experience more rounds in a shorter amount of time, increasing their chances of activating the jackpot multiple times during a session.

Benefits to Casinos: Casinos benefit from the increased number of rounds played per hour, as faster games lead to higher turnover and more betting opportunities. This criterion encourages players to make quicker decisions, reducing downtime between rounds and maximizing table efficiency. By promoting fast-paced gameplay, casinos may enhance the overall energy and excitement on the gaming floor, leading to longer play sessions and increased wager volumes.

### Example Walk-Through Scenario:

At a high-energy blackjack table, the dealer and players are moving through rounds quickly, completing each hand in under a minute. The system is configured to activate the Mystery Jackpot when rounds are completed within 60 seconds. After several rapid rounds, the system detects that the pace of the game has met the threshold, triggering the jackpot for all players at the table.

The players receive a notification on their screens, informing them that the jackpot is now live. Excited by the quick pace and the chance to win, the players place side bets on the jackpot for the next round. The fast-paced action continues, and after several more rounds, one of the players hits the jackpot, adding to the excitement of the quick gameplay.

### Example System Procedural Flow:

1. Game Speed Monitoring: The system tracks the time it takes to complete each round or game at LDGTs and ETGTs, recording the duration of each hand in real-time.
2. Speed Threshold Detection: When a round or game is completed within the predefined time limit (e.g., 60 seconds), the system identifies the rapid pace and triggers the activation of the Mystery Jackpot.
3. Jackpot Activation: The system notifies all players at the table that the jackpot is now live, allowing them to place side bets for the next round.
4. Player Participation: Players who are part of the fast-paced game may place side bets on the jackpot. The system logs all contributions to the jackpot pool and tracks player participation.
5. Jackpot Payout and Reset: After the jackpot is won, the system disburses the payout and resets the game speed tracking for future rounds. If the game continues at a fast pace, the jackpot may be triggered again.

### Noteworthy Aspects and Features:

Fast-Paced Gameplay: This criterion rewards players who enjoy quick, dynamic gameplay, encouraging them to stay engaged and make faster decisions.
Increased Game Turnover: Casinos benefit from faster game cycles, as more rounds are played in a shorter amount of time, leading to increased wager volumes.
Continuous Engagement: Players remain focused and excited as they aim to maintain the fast pace required to unlock the jackpot, resulting in longer play sessions and more frequent betting.

### Mystery Jackpot Enabling/Disabling Criteria #24—Dealer-Selected Activation

Description and Implementation: This enabling criterion allows the dealer to manually activate the Mystery Jackpot at their discretion, typically to reward players for sustained participation, high bets, or specific game outcomes. The dealer's decision to activate the jackpot may be based on a variety of factors, such as player loyalty, table dynamics, or a special event. The dealer interacts with the casino's system, which triggers the jackpot for all players at the table once the activation is confirmed.

For instance, in a poker game, the dealer may choose to activate the jackpot when a player makes an exceptionally bold move, such as going all-in, or when the table has reached a high level of activity. This feature adds an element of surprise, as players never know when the dealer may decide to reward them with a chance to win the jackpot.

Benefits to Players: Players benefit from the unpredictability and excitement of having the dealer personally activate the jackpot. This criterion adds a human touch to the game, making players feel recognized and rewarded for their participation or strategic decisions. The opportunity for the dealer to surprise players with the jackpot creates a dynamic and engaging gaming environment that keeps players on their toes.

Benefits to Casinos: Casinos benefit from the added flexibility that this criterion offers, as dealers may use their discretion to activate the jackpot based on the table's energy or player behavior. This flexibility allows the casino to tailor the gaming experience to specific situations, such as high-stakes play or player loyalty. By empowering dealers to trigger the jackpot, casinos may create a more personalized and engaging atmosphere, encouraging longer play sessions and higher bet volumes.

### Example Walk-Through Scenario:

At a high-stakes poker table, the players have been engaged in intense gameplay for over an hour, with several large bets and bold moves being made. The dealer, noticing the high level of excitement and participation at the table, decides to reward the players by activating the Mystery Jackpot. The dealer inputs a command into the system, and the jackpot is triggered for all players at the table.

The players, surprised and thrilled by the dealer's decision, place side bets for the jackpot in the next round. The sudden activation of the jackpot adds to the excitement of the game, and after a few more rounds, one of the players wins the jackpot. The dealer's ability to surprise the players with this opportunity enhances the overall gaming experience and keeps everyone engaged.

### Example System Procedural Flow:

1. Dealer Decision: The dealer assesses the dynamics at the table, considering factors such as player participation, bet sizes, and game outcomes. Based on these observations, the dealer decides whether to activate the Mystery Jackpot.
2. Manual Activation: The dealer interacts with the casino system, manually triggering the jackpot for the table.

The system sends a signal to all connected ETGTs and LDGTs, activating the jackpot feature.
3. Player Notification: Players at the table receive a notification that the dealer has activated the jackpot, allowing them to place side bets for the next round.
4. Player Participation: The system logs all side bets and contributions to the jackpot pool, tracking player participation and ensuring that everyone has a fair chance to win the jackpot.
5. Jackpot Payout and Reset: Once the jackpot is won, the system disburses the payout and resets the feature.

The dealer retains the ability to manually activate the jackpot again in the future, based on table dynamics.

### Noteworthy Aspects and Features:

Dealer-Controlled Activation: This criterion adds a personal touch to the game, empowering the dealer to reward players based on their participation and strategic decisions.
Surprise Factor: The unpredictability of the dealer's activation keeps players engaged, as they never know when the jackpot may be triggered.
Tailored Experience: Casinos benefit from the flexibility to activate the jackpot based on real-time player behavior, allowing for a more personalized and dynamic gaming experience.

### Mystery Jackpot Enabling/Disabling Criteria #25—Environmental Triggers

Description and Implementation: This criterion ties the activation of the Mystery Jackpot to environmental triggers within the casino, such as changes in lighting, music, or temperature. The casino's system monitors these environmental factors and activates the jackpot when a specific trigger is detected. This feature creates an immersive experience, where the ambiance of the casino influences gameplay and adds to the excitement.

For example, during a themed night at the casino, the lighting may change to a special color pattern, signaling the activation of the Mystery Jackpot across all LDGTs and ETGTs. Players are immediately notified that the jackpot is live, and they may place side bets to participate in the jackpot during the altered environmental state.

Benefits to Players: Players enjoy the immersive and dynamic atmosphere that environmental triggers create. The connection between the casino's ambiance and the jackpot feature adds an extra layer of excitement, making the gaming experience more engaging and memorable. Players are also encouraged to pay attention to the environmental cues, adding a sense of anticipation as they wait for the next trigger that may unlock the jackpot.

Benefits to Casinos: Casinos benefit from the ability to create a unique and exciting atmosphere that drives player engagement. By tying the jackpot activation to environmental triggers, casinos may control when and how often the jackpot is activated, using it to enhance special events or themed nights. This feature also adds a distinctive element to the casino's branding, making it more memorable for players and encouraging repeat visits.

### Example Walk-Through Scenario:

During a “Neon Nights” promotion at the casino, the lighting system is programmed to change to neon colors every hour, signaling the activation of the Mystery Jackpot. As the clock strikes 9:00 PM, the lights across the gaming floor shift to bright neon hues, and players at all connected ETGTs and LDGTs receive notifications that the jackpot is now live.

Sarah, who is playing at a baccarat table, notices the lighting change and quickly places a side bet for the jackpot. The environmental trigger adds to the excitement of the promotion, and players across the casino eagerly place their bets. After several rounds, one player wins the jackpot, and the lighting returns to normal until the next activation hour.

### Example System Procedural Flow:

1. Environmental Monitoring: The casino system tracks various environmental factors, such as lighting, music, or temperature, monitoring for predefined triggers.
2. Trigger Detection: When the environmental conditions meet the predefined criteria (e.g., a change in lighting), the system activates the Mystery Jackpot across all connected ETGTs and LDGTs.
3. Player Notification: Players are notified of the jackpot activation through visual cues (e.g., lighting changes) and on-screen messages, allowing them to place side bets for the jackpot.
4. Player Participation: The system logs all side bets and contributions to the jackpot pool, tracking player participation and ensuring that everyone has an equal opportunity to win the jackpot.
5. Jackpot Payout and Reset: Once the jackpot is won, the system disburses the payout and resets the environmental triggers for future activations. The casino may adjust the environmental conditions to control when the jackpot is activated again.

### Noteworthy Aspects and Features:

Immersive Experience: Environmental triggers create a dynamic and engaging atmosphere, making the casino experience more immersive and exciting for players.
Brand Differentiation: Casinos may use environmental triggers to create a unique and memorable experience, enhancing their brand identity and encouraging repeat visits.
Controlled Activation: Casinos may control when and how often the jackpot is activated, using environmental triggers to align the jackpot with special events or promotional nights.

### Mystery Jackpot Enabling/Disabling Criteria #26—Achieving a Specific Game Goal

Description and Implementation: This enabling criterion activates the Mystery Jackpot when a player achieves a specific, predefined goal within a game, such as winning a certain number of rounds consecutively, reaching a specific score in baccarat, or accumulating a target number of points in a multi-round poker session. The system monitors player performance and game statistics, and when the player meets the set goal, the jackpot feature is triggered for that player, creating a highly rewarding experience.

For instance, in a blackjack game, a player who wins five rounds in a row may trigger the Mystery Jackpot, allowing them to participate in the jackpot in addition to receiving their standard winnings. This feature encourages players to aim for specific in-game milestones, enhancing both the strategy and excitement of each session.

Benefits to Players: Players are rewarded for reaching notable milestones within the game, adding an element of accomplishment to their gaming experience. The possibility of unlocking the Mystery Jackpot based on their performance enhances the strategic depth of the game, motivating players to aim for specific goals. This criterion makes gameplay more engaging and satisfying, as players feel a greater sense of control and achievement when they unlock the jackpot through their own skill or persistence.

Benefits to Casinos: Casinos benefit from increased player retention and longer play sessions, as players are motivated to continue playing until they reach the specific game goal that activates the jackpot. By offering rewards for in-game milestones, casinos may encourage higher wager volumes and sustained player engagement. This feature also creates opportunities for casinos to introduce new goals or challenges in different games, keeping the gaming experience fresh and exciting for patrons.

### Example Walk-Through Scenario:

At a blackjack table, Michael has been on a winning streak, successfully winning three rounds in a row. He knows that if he wins two more rounds consecutively, the system will trigger the Mystery Jackpot. Focused on achieving this goal, Michael places larger bets in hopes of securing his fifth consecutive win.

After a tense few rounds, Michael wins his fifth hand, and the system activates the Mystery Jackpot, displaying a notification on his screen. Excited by the opportunity, he places a side bet to participate in the jackpot. The atmosphere at the table becomes more electric as other players also increase their bets, hoping to reach similar milestones and unlock their own jackpot chances.

### Example System Procedural Flow:

1. Game Goal Monitoring: The system tracks each player's progress toward predefined in-game goals, such as consecutive wins or accumulating a certain number of points, at LDGTs and ETGTs.
2. Goal Achievement Detection: When a player reaches the specified game goal (e.g., five consecutive wins), the system triggers the activation of the Mystery Jackpot for that player.
3. Jackpot Activation: The player is notified that the jackpot is now live, and they may place side bets to participate in the jackpot for the next round.
4. Player Participation: The system logs all side bets and jackpot contributions, ensuring that the player has a chance to win the jackpot based on their achievement.
5. Jackpot Payout and Reset: Once the jackpot is won, the system disburses the payout and resets the goal tracking for future game sessions.

### Noteworthy Aspects and Features:

Goal-Based Reward: This feature enhances gameplay by rewarding players for reaching specific milestones, making their progress more meaningful.
Strategic Gameplay: Players are incentivized to focus on achieving in-game goals, which adds an extra layer of strategy and engagement to each session.
Extended Playtime: The opportunity to unlock the jackpot based on performance encourages longer play sessions and higher wager volumes, benefiting both players and the casino.

### Mystery Jackpot Enabling/Disabling Criteria #27—Bet Size Multiplier Trigger

Description and Implementation: This enabling criterion activates the Mystery Jackpot when a player's bet reaches or exceeds a specific multiplier of the table's minimum bet (e.g., 10× or 20× the minimum bet). The system tracks the size of each player's bets in real-time, and when a player places a bet that meets or surpasses the multiplier threshold, the jackpot becomes available. This feature is designed to reward players who make larger, high-risk bets, adding an element of risk and reward to the gaming experience.

For example, in a baccarat game with a minimum bet of $100, the Mystery Jackpot may be triggered when a player places a bet of $2,000 or more (20× the minimum). Once the high-stakes bet is placed, the player becomes eligible for the jackpot, increasing the excitement of the round.

Benefits to Players: Players who enjoy high-stakes betting are rewarded for their bold decisions with the opportunity to win the Mystery Jackpot. This criterion adds an extra layer of excitement to large bets, as players know that reaching the multiplier threshold may unlock significant rewards. High-rollers, in particular, are motivated to place larger bets, as they may see a direct link between their wager size and the potential for jackpot activation.

Benefits to Casinos: Casinos benefit from increased bet volumes, as players are incentivized to place larger bets to trigger the Mystery Jackpot. This feature encourages high-stakes play, leading to higher overall wager volumes and larger jackpot pools. By offering rewards for high-value bets, casinos may attract more high-rollers and create a more dynamic gaming environment, where players are motivated to take bigger risks for greater rewards.

### Example Walk-Through Scenario:

Sarah is playing at a baccarat table with a minimum bet of $100. After several rounds of play, she decides to place a high-stakes bet of $2,000, hoping to increase her winnings. As soon as her bet is placed, the system recognizes that it meets the 20× multiplier threshold and triggers the Mystery Jackpot for her. A notification appears on her screen, informing her that the jackpot is now active.

Excited by the prospect of winning a large prize, Sarah places an additional side bet to participate in the jackpot. Other players at the table, noticing her bold move, are inspired to increase their own bets, hoping to trigger the jackpot for themselves. The atmosphere at the table becomes more intense as high-stakes play continues.

### Example System Procedural Flow:

1. Bet Size Monitoring: The system tracks each player's bet sizes in real-time at LDGTs and ETGTs, monitoring for bets that meet or exceed the predefined multiplier threshold (e.g., 20× the minimum bet).
2. Multiplier Detection: When a player places a bet that meets or exceeds the multiplier (e.g., $2,000), the system triggers the activation of the Mystery Jackpot for that player.
3. Jackpot Activation: The player is notified that the jackpot is now live, and they may place side bets to participate in the jackpot for the next round.
4. Player Participation: The system logs all side bets and jackpot contributions from the player, ensuring that they have a chance to win the jackpot based on their high-stakes bet.
5. Jackpot Payout and Reset: After the jackpot is won, the system disburses the payout and resets the bet size tracking for future rounds.

### Noteworthy Aspects and Features:

High-Stakes Incentive: This criterion encourages players to place larger bets, increasing the overall wager volume and creating more opportunities for jackpot activation.
Direct Bet-Reward Link: Players are rewarded for making bold betting decisions, adding a tangible connection between their bet size and the potential for jackpot rewards.
Dynamic Gameplay: The high-risk, high-reward nature of this feature makes gameplay more exciting, attracting high-rollers and fostering a thrilling gaming environment.

### Mystery Jackpot Enabling/Disabling Criteria #28—Random Player Selection

Description and Implementation: This enabling criterion activates the Mystery Jackpot for a randomly selected player at a table. The system uses a random number generator (RNG) to choose a player at random, regardless of their performance, bet size, or previous outcomes. Once the player is selected, the Mystery Jackpot is triggered, and the chosen player is notified that they are eligible to participate in the jackpot. This criterion introduces an element of chance to the game, making every player feel that they may be the next jackpot winner.

For example, during a game of poker, the system may randomly select one of the players at the table to trigger the Mystery Jackpot, creating an unexpected opportunity for that player to win a significant prize.

Benefits to Players: Players enjoy the suspense and excitement of being randomly selected for the Mystery Jackpot, knowing that they may be chosen at any time, regardless of their performance. This feature keeps players engaged and motivated, as they know that every round may present a chance to win the jackpot. The element of randomness adds variety to the gameplay, making the experience more unpredictable and enjoyable for all players at the table.

Benefits to Casinos: Casinos benefit from increased player engagement and longer play sessions, as the random selection process keeps players invested in the game. The unpredictability of the jackpot activation encourages more consistent betting, as players want to remain eligible for random selection. This criterion also helps maintain excitement across all players, as everyone feels they have an equal chance of being selected for the jackpot, regardless of their bet size or strategy.

### Example Walk-Through Scenario:

At a poker table, five players are engaged in a lively game, each placing their bets for the current round. Without warning, the system randomly selects one of the players, John, to activate the Mystery Jackpot. A notification appears on John's screen, informing him that he has been randomly chosen for the jackpot.

Excited by the unexpected opportunity, John places a side bet to participate in the jackpot for the next round. The other players, intrigued by the random selection process, continue betting, hoping that they may be the next player chosen for the jackpot. The random activation keeps everyone at the table engaged and motivated to keep playing.

### Example System Procedural Flow:

1. RNG-Based Player Selection: The system uses a random number generator to select a player at the table, regardless of their performance, bet size, or previous outcomes.
2. Player Notification: Once a player is randomly selected, the system sends a notification to their terminal, informing them that the Mystery Jackpot is now active for them.
3. Jackpot Activation: The selected player may now place side bets to participate in the jackpot. The system logs all contributions to the jackpot pool and tracks the player's participation.
4. Player Participation: The selected player may place side bets for the duration of the jackpot activation. Other players at the table are not eligible unless they are randomly selected in future rounds.
5. Jackpot Payout and Reset: After the jackpot is won, the system disburses the payout and resets the random selection process for future rounds.

### Noteworthy Aspects and Features:

Equal Opportunity: The randomness of the selection process ensures that all players have an equal chance of triggering the jackpot, regardless of their performance or bet size.
Unpredictable Excitement: Players remain engaged and excited, knowing that they may be chosen for the jackpot at any time, adding an element of surprise to the game.
Increased Engagement: The random selection process encourages players to stay at the table longer, as they want to remain eligible for future jackpot activations.

### Mystery Jackpot Enabling/Disabling Criteria #29—Player'S Loyalty Tier Advancement

Description and Implementation: This criterion activates the Mystery Jackpot when a player advances to a higher tier in the casino's loyalty program. The system tracks each player's progress in the loyalty program, and when a player reaches a new tier (e.g., moving from Silver to Gold status), the Mystery Jackpot is triggered for that player. This feature rewards loyal players for their ongoing patronage, offering them an exclusive opportunity to win a jackpot based on their loyalty achievements.

For instance, when a player accumulates enough points to advance to the next tier, the system may automatically activate the Mystery Jackpot, giving them a limited-time window to place side bets and participate in the jackpot.

Benefits to Players: Players feel recognized and rewarded for their loyalty to the casino, as advancing to a higher tier not only brings additional benefits but also unlocks the chance to win a jackpot. This feature enhances the player's sense of achievement and encourages continued engagement with the loyalty program. Players are motivated to accumulate more points and reach higher tiers, knowing that each advancement brings exclusive rewards, including the possibility of winning a significant jackpot.

Benefits to Casinos: Casinos benefit from increased player retention and loyalty, as players are incentivized to continue participating in the loyalty program to unlock the Mystery Jackpot. This criterion encourages higher wager volumes and longer play sessions, as players aim to accumulate more points and advance to higher tiers. By offering exclusive jackpot opportunities to loyal players, casinos may strengthen their relationships with high-value patrons and foster long-term engagement.

### Example Walk-Through Scenario:

Emily, a regular player at the casino, has been steadily accumulating loyalty points through her frequent visits and high-value bets. After reaching the threshold required to advance from Gold to Platinum status, the system automatically activates the Mystery Jackpot for her. A notification appears on her screen, congratulating her on reaching Platinum status and informing her that she is now eligible to participate in the jackpot.

Excited by the recognition and reward for her loyalty, Emily places a side bet on the jackpot for the next round of baccarat. Her advancement to a higher loyalty tier not only unlocks additional perks but also adds excitement to her gaming session, making her feel valued as a VIP player.

### Example System Procedural Flow:

1. Loyalty Tier Monitoring: The system tracks each player's progress in the casino's loyalty program, updating their status as they accumulate points and advance through the tiers.
2. Tier Advancement Detection: When a player advances to a higher tier (e.g., moving from Gold to Platinum), the system triggers the activation of the Mystery Jackpot for that player.
3. Jackpot Activation: The player is notified that the jackpot is now live, and they may place side bets to participate in the jackpot.
4. Player Participation: The system logs all side bets and contributions to the jackpot pool, ensuring that the player has a chance to win the jackpot as a reward for their loyalty.
5. Jackpot Payout and Loyalty Reset: After the jackpot is won, the system disburses the payout and resets the player's loyalty progress for future tier advancements.

### Noteworthy Aspects and Features:

Loyalty-Based Reward: This feature enhances player retention by rewarding loyal players with exclusive opportunities to win the Mystery Jackpot, encouraging continued engagement with the casino's loyalty program.
Exclusive Access: Players feel valued and recognized when their loyalty tier advancement unlocks special rewards, including the chance to win a jackpot.
Increased Engagement: The desire to advance through the loyalty tiers motivates players to place higher bets and participate in longer play sessions, driving higher wager volumes for the casino.

### Mystery Jackpot Enabling/Disabling Criteria #30—Activation Based on Player Losing Streak

Description and Implementation: This enabling criterion activates the Mystery Jackpot when a player experiences a predefined losing streak, such as losing five consecutive rounds or more. The system tracks each player's performance at LDGTs (Live Dealer Game Tables) and ETGTs (Electronic Table Game Terminals) in real-time. When the system detects that a player has reached the required number of losses in a row, the Mystery Jackpot is triggered for that player, providing them with a chance to break their streak with a significant jackpot win.

For instance, in a blackjack game, if a player loses five rounds consecutively, the system will activate the Mystery Jackpot. The player is then given an opportunity to place a side bet in the next round for a chance to win the jackpot, potentially turning their bad luck into a big win.

Benefits to Players: Players experiencing a losing streak are given a unique opportunity to turn their fortunes around with the possibility of winning the Mystery Jackpot. This feature adds excitement and hope to a session that may otherwise feel discouraging. By offering a reward based on losses, players remain motivated to continue playing, knowing that their streak may eventually lead to a jackpot opportunity.

Benefits to Casinos: Casinos benefit from increased player retention, as players are less to walk away after experiencing a losing streak when they know the Mystery Jackpot may be triggered. This feature encourages players to keep betting, extending their playtime, and potentially increasing wager volumes. The system also helps balance player satisfaction, ensuring that even those with a run of bad luck have something to look forward to, fostering a positive overall gaming experience.

### Example Walk-Through Scenario:

James is playing blackjack at an ETGT but has been on a losing streak, losing four consecutive hands. Determined to turn his luck around, he places another bet, but unfortunately, he loses the fifth hand as well. The system detects that James has reached the losing streak threshold and immediately activates the Mystery Jackpot. A notification appears on his screen, offering him the opportunity to place a side bet for a chance to win the jackpot.

James, excited by the chance to recover some of his losses, places a side bet on the jackpot for the next round. Despite his poor luck so far, the prospect of winning the jackpot energizes him, and he continues playing with renewed hope. After a few more rounds, James wins the jackpot, breaking his losing streak and turning his night around.

### Example System Procedural Flow:

1. Performance Tracking: The system monitors each player's performance at LDGTs and ETGTs, recording the outcomes of each round in real-time.
2. Losing Streak Detection: When a player reaches the predefined losing streak threshold (e.g., five consecutive losses), the system activates the Mystery Jackpot for that player.
3. Jackpot Activation: The system notifies the player that the jackpot is now live, and they may place side bets to participate in the jackpot for the next round.
4. Player Participation: The system logs all side bets and jackpot contributions from the player, ensuring that they have a chance to win the jackpot and break their losing streak.
5. Jackpot Payout and Reset: Once the jackpot is won, the system disburses the payout and resets the player's losing streak tracking for future sessions.

### Noteworthy Aspects and Features:

Losing Streak Reward: This criterion helps maintain player morale by offering a chance to win a jackpot even during periods of bad luck.
Increased Retention: Players are less to leave the table after a losing streak, as they know that continued play may trigger the Mystery Jackpot.
Balanced Player Satisfaction: By rewarding players for persistence, casinos ensure that both winning and losing players have something to look forward to, enhancing the overall gaming experience.

### Mystery Jackpot Enabling/Disabling Criteria #31—Activation During High Traffic or Busy Periods

Description and Implementation: This enabling criterion activates the Mystery Jackpot during periods of high casino traffic, such as peak hours, weekends, or during special events when the casino is particularly busy. The system is programmed to monitor player activity and table occupancy across the casino floor, and when a predefined threshold of active players or tables is reached, the Mystery Jackpot is triggered across all participating LDGTs and ETGTs. This creates an exciting, bustling atmosphere, encouraging players to participate while the jackpot is available.

For instance, the casino may configure the system to activate the Mystery Jackpot once 75% of the available tables are occupied, or when the number of players in the casino reaches a specific level. The jackpot remains active during this high-traffic period, drawing in more players to participate in the shared excitement.

Benefits to Players: Players benefit from the heightened energy and excitement of playing during busy periods, knowing that the Mystery Jackpot is available. The anticipation of a large crowd and the opportunity to win a significant prize add to the overall enjoyment of the casino experience. Players are also more to engage in side bets and higher wagers during these periods, knowing that the jackpot may be triggered at any moment.

Benefits to Casinos: Casinos benefit from increased participation and higher wager volumes during busy periods, as the activation of the Mystery Jackpot incentivizes players to place more bets and stay longer. This feature helps maximize revenue during peak hours, when player traffic is already high. By linking the jackpot to periods of high activity, casinos may create a lively, engaging atmosphere that encourages more frequent play and increases overall table occupancy.

### Example Walk-Through Scenario:

On a busy Saturday night, the casino is bustling with players at nearly every table. As the number of active players reaches the casino's predefined threshold, the system automatically activates the Mystery Jackpot across all LDGTs and ETGTs. A message appears on the screens of players at every table, informing them that the jackpot is live and available for the duration of the busy period.

Mary, playing at a baccarat table, notices the notification and places a side bet for the jackpot. The excitement on the gaming floor increases as more players place side bets, eager to participate in the jackpot while it's available. The high-traffic atmosphere adds to the sense of urgency, and after a few rounds, one of the players hits the jackpot, heightening the excitement even further.

### Example System Procedural Flow:

1. Traffic Monitoring: The system monitors player activity and table occupancy across the casino in real-time, tracking the number of active players and tables.
2. High-Traffic Detection: When the number of active players or tables reaches the predefined threshold (e.g.,
75% table occupancy), the system triggers the activation of the Mystery Jackpot across all participating LDGTs and ETGTs.
3. Jackpot Activation: The system notifies players at every table that the jackpot is now live, allowing them to place side bets to participate.
4. Player Participation: The system logs all side bets and contributions to the jackpot pool, ensuring that players at all active tables have an equal chance to win the jackpot.
5. Jackpot Payout and Reset: Once the jackpot is won, the system disburses the payout and resets the high-traffic threshold for future activations during busy periods.

### Noteworthy Aspects and Features:

Peak Hour Incentive: This criterion maximizes player engagement and wager volumes during busy periods, driving higher revenue for the casino.
Lively Atmosphere: The activation of the jackpot during high-traffic times adds to the excitement on the gaming floor, encouraging more frequent and higher wagers.
Increased Player Participation: Players are more to participate in the jackpot when they see that the casino is busy and the energy level is high, leading to longer play sessions and greater overall engagement.

### Mystery Jackpot Enabling/Disabling Criteria #32—Sequential Game Trigger

Description and Implementation: This enabling criterion activates the Mystery Jackpot when a specific sequence of games is played, such as a player switching between different game types (e.g., blackjack to baccarat to roulette) or completing a certain number of rounds in multiple games. The system tracks player activity across different games and, once the predefined sequence is completed, the jackpot is triggered for that player. This feature encourages players to explore various games and engage in multi-game play.

For example, a player who plays three rounds of blackjack, followed by three rounds of baccarat, and then switches to roulette may trigger the Mystery Jackpot. The system recognizes the completion of the sequence and activates the jackpot, rewarding players for their diverse gameplay.

Benefits to Players: Players are encouraged to explore different game types and enjoy a more varied gaming experience. The opportunity to unlock the Mystery Jackpot by playing multiple games adds excitement and variety to their session, making each game feel more rewarding. Players who enjoy trying different games will appreciate the added incentive to switch between tables, knowing that their diverse gameplay may lead to a significant jackpot.

Benefits to Casinos: Casinos benefit from increased cross-game engagement, as players are incentivized to try different games to trigger the jackpot. This feature helps distribute player traffic more evenly across the gaming floor, ensuring that multiple games receive attention. By encouraging players to explore a wider variety of games, casinos may increase overall wager volumes and extend player engagement, leading to longer play sessions and more frequent betting.

### Example Walk-Through Scenario:

John, a frequent casino visitor, decides to try a variety of games during his session. He starts with three rounds of blackjack at an ETGT, then moves on to baccarat for another three rounds. After completing his baccarat session, he switches to roulette, where he plays a few more rounds. The system, tracking John's game activity, recognizes that he has completed the predefined sequence of games and activates the Mystery Jackpot.

A notification appears on John's screen, informing him that the jackpot is now available. Excited by the prospect of winning a large prize, John places a side bet on the jackpot for his next round of roulette. The variety of games keeps John engaged and entertained throughout his session, and the activation of the jackpot adds to the overall enjoyment of his night.

### Example System Procedural Flow:

1. Game Sequence Monitoring: The system tracks each player's activity across different games at LDGTs and ETGTs, recording the completion of specific sequences of games or rounds.
2. Sequence Completion Detection: When a player completes the predefined sequence of games (e.g., three rounds of blackjack, followed by three rounds of baccarat), the system triggers the activation of the Mystery Jackpot.
3. Jackpot Activation: The system notifies the player that the jackpot is now live, and they may place side bets to participate in the jackpot for the next round.
4. Player Participation: The system logs all side bets and jackpot contributions, ensuring that the player has a chance to win the jackpot based on their multi-game activity.
5. Jackpot Payout and Reset: After the jackpot is won, the system disburses the payout and resets the game sequence tracking for future sessions.

### Noteworthy Aspects and Features:

Multi-Game Engagement: This criterion encourages players to try different games and explore the casino floor, leading to increased player traffic across multiple game types.
Varied Gameplay Experience: Players enjoy a more dynamic and varied gaming experience, as they are incentivized to switch between games to unlock the jackpot.
Extended Play Sessions: The requirement to complete a sequence of games encourages longer play sessions, as players remain engaged and motivated to reach the jackpot activation point.

### Mystery Jackpot Enabling/Disabling Criteria #33—Jackpot Activation During Off-Peak Hours

Description and Implementation: This enabling criterion triggers the Mystery Jackpot during off-peak hours, such as early mornings or weekdays when the casino experiences lower traffic. The system is programmed to activate the jackpot automatically during these quieter times, encouraging players to visit and play during periods when the casino floor is less busy. This strategy helps balance player traffic and incentivizes off-peak participation.

For example, the casino may configure the system to activate the Mystery Jackpot between 2:00 AM and 6:00 AM, offering players who visit during these hours an exclusive opportunity to win the jackpot. This feature creates a time-sensitive reward that encourages players to visit during slower periods.

Benefits to Players: Players who prefer to visit the casino during quieter hours are rewarded with exclusive access to the Mystery Jackpot, making their off-peak visits more exciting. The opportunity to win a significant prize during these hours adds an extra incentive for players to plan their visits around the jackpot's availability. Players may also appreciate the more relaxed atmosphere of playing during off-peak times, with the added benefit of a potential jackpot win.

Benefits to Casinos: Casinos benefit from increased player traffic and higher wager volumes during off-peak hours, as the activation of the Mystery Jackpot encourages more visits and extended play sessions during slower periods. This feature helps balance player traffic throughout the day, ensuring that the casino floor remains active even during traditionally quieter times. By offering time-sensitive rewards, casinos may attract more players and increase revenue during off-peak hours.

### Example Walk-Through Scenario:

At 3:00 AM on a weekday, the casino is relatively quiet, with only a few players scattered across the tables. The system, recognizing that this is an off-peak period, automatically activates the Mystery Jackpot across all LDGTs and ETGTs. A notification appears on the screens of the players currently at the tables, informing them that the jackpot is now live and available for the next few hours.

David, who prefers playing during quieter times, notices the notification and places a side bet for the jackpot while playing roulette. The exclusive availability of the jackpot during off-peak hours adds excitement to his session, and he continues playing, knowing that he has a chance to win the jackpot with fewer competitors. After a few rounds, one of the players hits the jackpot, adding a thrilling conclusion to the quiet night.

### Example System Procedural Flow:

1. Off-Peak Hour Monitoring: The system tracks the time of day and identifies periods of lower player traffic, such as early mornings or weekdays, to trigger the jackpot activation.
2. Time-Based Jackpot Activation: When the system detects that the current time falls within the predefined off-peak hours (e.g., 2:00 AM to 6:00 AM), the Mystery Jackpot is automatically activated across all participating LDGTs and ETGTs.
3. Player Notification: Players at the tables are notified that the jackpot is live, and they may place side bets to participate during the off-peak hours.
4. Player Participation: The system logs all side bets and contributions to the jackpot pool, ensuring that players participating during off-peak hours have a chance to win the jackpot.
5. Jackpot Payout and Reset: Once the jackpot is won, the system disburses the payout and resets the off-peak hour tracking for future activations.

### Noteworthy Aspects and Features:

Off-Peak Incentive: This feature helps casinos increase player traffic and engagement during quieter periods by offering exclusive jackpot opportunities.
Time-Sensitive Rewards: Players are incentivized to visit the casino during specific times to take advantage of the jackpot, helping casinos balance player traffic throughout the day.
Balanced Player Experience: The availability of the jackpot during off-peak hours ensures that all players, regardless of when they visit, have an equal opportunity to participate in and win the jackpot.

### Mystery Jackpot Enabling/Disabling Criteria #34—Player Joining a Table at a Specific Time

Description and Implementation: This enabling criterion triggers the Mystery Jackpot when a player joins a game table at a specific time or during a specific time window predetermined by the casino. The system tracks when players join LDGTs (Live Dealer Game Tables) or ETGTs (Electronic Table Game Terminals) and activates the jackpot for players who sit down or log in during the designated time slot. The time window may be set around promotions, events, or quieter hours to encourage participation.

For instance, the casino may configure the system to activate the Mystery Jackpot for players who join a table between 4:00 PM and 6:00 PM on weekdays as part of a “Happy Hour” promotion. Once the player joins within the eligible window, the jackpot is activated for that player, adding excitement to their gaming session.

Benefits to Players: Players who join tables during specific times are rewarded with exclusive access to the Mystery Jackpot, adding value to their visit. This time-based reward encourages players to plan their gaming sessions around the designated windows, knowing that they have an additional chance to win the jackpot. The time-sensitive nature of the feature adds anticipation to the session, as players feel they are being rewarded for their timely participation.

Benefits to Casinos: Casinos benefit by driving player traffic to specific times of the day or week, ensuring that tables remain occupied during slower periods or promotional events. This feature allows casinos to strategically schedule promotions that align with their operational goals, such as filling tables during off-peak hours or encouraging participation during special events. By offering time-based jackpots, casinos may create a more dynamic and engaging gaming environment.

### Example Walk-Through Scenario:

At 5:30 PM, during a “Happy Hour” promotion, Lisa decides to sit down at a baccarat table. The system is programmed to trigger the Mystery Jackpot for any player who joins between 4:00 PM and 6:00 PM on weekdays. As soon as Lisa sits down and places her first bet, a notification appears on her screen, informing her that she is now eligible to participate in the jackpot due to her timely arrival.

Lisa, excited by the unexpected opportunity, places a side bet for the jackpot in the next round. Other players at the table, noticing her notification, also decide to place bets, hoping they too may capitalize on the special promotion. After several rounds, Lisa wins the jackpot, making her early evening visit particularly rewarding.

### Example System Procedural Flow:

1. Time Monitoring: The system tracks the current time and checks for predefined promotional windows (e.g.,
4:00 PM to 6:00 PM). The system is aware of these windows across all LDGTs and ETGTs.
2. Player Join Detection: When a player joins a table during the designated time window, the system recognizes their participation and triggers the activation of the Mystery Jackpot.
3. Jackpot Activation: The player is notified that the jackpot is now active for them, and they may place side bets to participate in the jackpot for upcoming rounds.
4. Player Participation: The system logs all side bets and contributions to the jackpot pool, ensuring that the player has a chance to win the jackpot based on their timely participation.
5. Jackpot Payout and Reset: Once the jackpot is won, the system disburses the payout and resets the time tracking for future promotions.

### Noteworthy Aspects and Features:

Time-Based Reward: This criterion encourages players to join tables at specific times, creating a sense of urgency and excitement for timely participation.
Targeted Promotions: Casinos may use this feature to drive traffic during slower periods or to promote special events, ensuring that tables remain filled and engaging for players.
Dynamic Engagement: Players enjoy the added benefit of participating in time-sensitive jackpots, making their visit more exciting and potentially more rewarding.

### Mystery Jackpot Enabling/Disabling Criteria #35—Activation Based on Casino-Wide Wager Volume

Description and Implementation: This enabling criterion triggers the Mystery Jackpot when the total wager volume across the casino reaches a predefined threshold. The system continuously monitors the total amount wagered across all LDGTs and ETGTs in real-time, and once the threshold is met, the jackpot is activated for all players in the casino. This feature adds an element of collective achievement, as all players contribute to the total wager pool, and everyone benefits when the threshold is reached.

For example, the casino may set the threshold at $1 million in total wagers across the gaming floor. Once players collectively wager this amount, the Mystery Jackpot is activated, giving everyone in the casino an opportunity to participate in the jackpot regardless of their individual contribution.

Benefits to Players: Players enjoy the sense of camaraderie and excitement that comes with contributing to a shared goal. The knowledge that their wagers are contributing to a casino-wide jackpot keeps players engaged and motivated to continue betting. This feature encourages players to participate more actively, as they want to be part of the collective effort that triggers the jackpot for everyone.

Benefits to Casinos: Casinos benefit from increased wager volumes, as players are motivated to place more bets to help reach the casino-wide threshold. This feature encourages collective participation and keeps the entire gaming floor engaged, leading to higher overall revenues. By setting a high but achievable target, casinos may ensure sustained player engagement and a more dynamic, exciting atmosphere.

### Example Walk-Through Scenario:

Throughout the day, players across the casino are placing wagers at various tables. The system tracks all wagers in real-time, and as the total wager volume approaches the $1 million threshold, a display on the casino floor shows the growing progress. Players become excited as they realize the jackpot is about to be triggered.

At 9:00 PM, the total wager volume surpasses $1 million, and the system automatically activates the Mystery Jackpot across all LDGTs and ETGTs. Players at every table receive notifications that the jackpot is now live, and they may place side bets to participate. The collective excitement on the gaming floor leads to a surge in side bets, and after several rounds, one lucky player wins the jackpot, adding to the celebratory atmosphere.

### Example System Procedural Flow:

1. Wager Volume Monitoring: The system continuously tracks the total wager volume across all LDGTs and ETGTs in real-time, updating the cumulative amount as players place bets.
2. Threshold Detection: When the total wager volume reaches the predefined threshold (e.g., $1 million), the system triggers the activation of the Mystery Jackpot for all players in the casino.
3. Jackpot Activation: The system notifies players at all tables that the jackpot is now live, and they may place side bets to participate in the jackpot.
4. Player Participation: The system logs all side bets and contributions to the jackpot pool from players across the casino, ensuring that everyone has an equal chance to win.
5. Jackpot Payout and Reset: Once the jackpot is won, the system disburses the payout and resets the wager volume tracking for future activations.

### Noteworthy Aspects and Features:

Collective Achievement: This criterion fosters a sense of shared excitement and accomplishment, as all players contribute to the total wager pool and benefit from the jackpot activation.
Increased Wager Volumes: Casinos benefit from higher wager volumes, as players are motivated to place more bets to help reach the threshold.
Casino-Wide Engagement: This feature keeps the entire gaming floor engaged, creating a lively and dynamic atmosphere as players work together to trigger the jackpot.

### Mystery Jackpot Enabling/Disabling Criteria #36—Game-Specific Milestones

Description and Implementation: This enabling criterion activates the Mystery Jackpot when a specific milestone is reached within a particular game. The system tracks player progress toward predefined milestones in individual games, such as reaching 100 rounds in blackjack, winning a certain number of hands in baccarat, or completing a set number of spins in roulette. When a player achieves the game-specific milestone, the jackpot is activated for that player or for all players at the table, depending on the casino's configuration.

For instance, in a poker game, the system may trigger the Mystery Jackpot when a player completes 50 rounds or wins five consecutive hands. The milestone-based activation rewards players for their persistence and long-term engagement with the game.

Benefits to Players: Players are motivated to keep playing as they work toward specific game milestones that offer the potential to unlock the jackpot. This feature adds an element of progression to the gaming experience, rewarding players for their commitment to a particular game. The anticipation of reaching a milestone and unlocking the jackpot adds excitement and a sense of accomplishment to the gaming session.

Benefits to Casinos: Casinos benefit from longer play sessions, as players are incentivized to continue playing in order to reach the game-specific milestones that trigger the jackpot. This feature encourages players to stay at the table for extended periods, increasing overall wager volumes and engagement. By offering rewards tied to specific game milestones, casinos may promote sustained participation and loyalty to certain games.

### Example Walk-Through Scenario:

Sophia has been playing blackjack at an ETGT for several hours and is close to reaching the milestone of 100 rounds played. The system tracks her progress, and as she completes her 100th round, the Mystery Jackpot is automatically activated for her. A notification appears on her screen, congratulating her on reaching the milestone and offering her the opportunity to place a side bet for the jackpot.

Excited by the reward for her persistence, Sophia places a side bet for the next round, hoping to win the jackpot. The milestone-based activation keeps her engaged, and she continues playing, knowing that her long-term gameplay has been recognized and rewarded.

### Example System Procedural Flow:

1. Milestone Tracking: The system tracks each player's progress toward specific game milestones at LDGTs and ETGTs, such as the number of rounds played or hands won.
2. Milestone Detection: When a player reaches the predefined milestone (e.g., 100 rounds played), the system triggers the activation of the Mystery Jackpot for that player or table.
3. Jackpot Activation: The player is notified that the jackpot is now live, and they may place side bets to participate in the jackpot for the next round.
4. Player Participation: The system logs all side bets and contributions to the jackpot pool, ensuring that the player has a chance to win the jackpot based on their milestone achievement.
5. Jackpot Payout and Reset: After the jackpot is won, the system disburses the payout and resets the milestone tracking for future sessions.

### Noteworthy Aspects and Features:

Milestone-Based Rewards: This criterion rewards players for reaching specific milestones in a game, adding a sense of progression and accomplishment to the gaming experience.
Extended Play Sessions: Players are incentivized to stay at the table longer in order to reach the milestone that triggers the jackpot, increasing overall engagement and wager volumes.
Game Loyalty: By tying the jackpot to game-specific milestones, casinos may encourage long-term participation in particular games, fostering player loyalty.

### Mystery Jackpot Enabling/Disabling Criteria #37—Activation for High-Ranking Players in Leaderboards

Description and Implementation: This enabling criterion triggers the Mystery Jackpot for players who achieve high rankings on casino leaderboards, which track performance across various games. The system integrates with the casino's leaderboard system, monitoring player performance and rankings in real-time. When a player reaches a top position on a leaderboard (e.g., top five players for the day or week), the jackpot is activated for that player, offering a reward for their exceptional performance.

For example, in a poker tournament, the system may activate the Mystery Jackpot for the top three players on the leaderboard. The higher a player's ranking, the greater their chances of participating in the jackpot, adding an extra layer of competition to the game.

Benefits to Players: Players who enjoy competitive gaming are rewarded for their high performance and leaderboard rankings. The opportunity to unlock the jackpot by achieving a top position adds motivation and excitement to the gaming experience, encouraging players to strive for excellence. This feature enhances the competitive aspect of the game, giving players additional incentives to perform well and climb the leaderboard.

Benefits to Casinos: Casinos benefit from increased competition and engagement, as players are motivated to improve their rankings in order to unlock the jackpot. This feature encourages higher wager volumes and longer play sessions, as players compete to reach the top of the leaderboard. By offering rewards tied to leaderboard performance, casinos may foster a competitive and dynamic gaming environment that keeps players coming back.

### Example Walk-Through Scenario:

Jake has been participating in a poker tournament and is currently ranked in the top five on the leaderboard. As the tournament progresses, he wins several notable hands, boosting his ranking to second place. The system, integrated with the casino's leaderboard, recognizes his achievement and automatically activates the Mystery Jackpot for him. A notification appears on Jake's screen, congratulating him for his high ranking and offering him the opportunity to participate in the jackpot.

Jake places a side bet for the next round, excited by the recognition of his leaderboard performance. The competition heats up as other players try to climb the leaderboard and trigger the jackpot for themselves. The leaderboard-based activation adds an extra layer of intensity to the tournament, making every hand more exciting.

### Example System Procedural Flow:

1. Leaderboard Monitoring: The system tracks player performance and rankings on casino leaderboards, updating in real-time as players win rounds and improve their positions.
2. High-Ranking Detection: When a player reaches a top position on the leaderboard (e.g., top five players), the system triggers the activation of the Mystery Jackpot for that player.
3. Jackpot Activation: The player is notified that the jackpot is now live, and they may place side bets to participate in the jackpot for the next round.
4. Player Participation: The system logs all side bets and contributions to the jackpot pool, ensuring that the high-ranking player has a chance to win the jackpot.
5. Jackpot Payout and Reset: After the jackpot is won, the system disburses the payout and resets the leaderboard tracking for future competitions.

### Noteworthy Aspects and Features:

Competitive Reward: This criterion rewards players for achieving high rankings on casino leaderboards, adding excitement and motivation for competitive players.
Increased Competition: The activation of the jackpot based on leaderboard performance encourages higher wager volumes and longer play sessions as players strive to improve their rankings.
Dynamic Gameplay: The integration of leaderboards and jackpot rewards creates a more competitive and engaging gaming environment, fostering long-term player retention.

### Mystery Jackpot Enabling/Disabling Criteria #38—Activation for New Player Registrations

Description and Implementation: This enabling criterion activates the Mystery Jackpot when a player registers for the first time in the casino's system or signs up for a loyalty or membership program. The system recognizes new player profiles and automatically triggers the jackpot feature, providing a welcome bonus for first-time players. This may be implemented at both LDGTs (Live Dealer Game Tables) and ETGTs (Electronic Table Game Terminals) by integrating the jackpot system with the casino's registration and player tracking software.

For example, when a player creates a new account or enrolls in the loyalty program, the system activates the Mystery Jackpot, offering them the opportunity to participate in the jackpot for a limited time. The feature serves as a promotion to encourage new players to engage immediately after registration.

Benefits to Players: New players receive an immediate reward for joining the casino, creating a positive first impression. The opportunity to participate in the Mystery Jackpot enhances their initial gaming experience, making them feel welcomed and appreciated. This feature incentivizes players to begin their gaming sessions right after registration, providing them with a chance to win a significant prize early on.

Benefits to Casinos: Casinos benefit from increased player acquisition, as the promise of a jackpot opportunity upon registration may attract new customers. This feature encourages immediate engagement from new players, who are to start betting and participating in the jackpot right after signing up. By linking the jackpot to new registrations, casinos may boost loyalty program enrollments and drive player participation from the outset.

### Example Walk-Through Scenario:

Samantha visits the casino for the first time and decides to register for the loyalty program. After completing her registration at an ETGT, she receives a notification on her screen informing her that the Mystery Jackpot has been activated as a welcome bonus for new players. Samantha is excited by the opportunity to participate in the jackpot and quickly places a side bet for the next round of roulette.

As a new player, Samantha feels rewarded for joining the loyalty program and begins her gaming session with added excitement. The jackpot activation encourages her to explore more games and place higher bets, knowing that her participation may lead to a significant win. After several rounds, one of the players at the table wins the jackpot, creating a celebratory atmosphere.

### Example System Procedural Flow:

1. Registration Detection: The system monitors player registration activities at LDGTs and ETGTs, detecting new accounts or loyalty program sign-ups.
2. New Player Identification: When a new player completes their registration or loyalty program enrollment, the system triggers the activation of the Mystery Jackpot for that player.
3. Jackpot Activation: The new player is notified that the jackpot is live and available for them. They may place side bets to participate in the jackpot during their initial gaming session.
4. Player Participation: The system logs all side bets and jackpot contributions from the new player, ensuring that they have an equal chance to win the jackpot based on their registration bonus.
5. Jackpot Payout and Reset: After the jackpot is won, the system disburses the payout and resets the new player tracking for future registrations.

### Noteworthy Aspects and Features:

Welcome Bonus: This criterion provides an immediate reward for new players, encouraging them to start betting and participating in the jackpot right after registration.
Increased Player Acquisition: Casinos may attract more new players by offering exclusive jackpot opportunities upon registration, enhancing player acquisition and loyalty program enrollment.
Immediate Engagement: By activating the jackpot for new players, casinos ensure that newcomers begin their gaming sessions with excitement and motivation, leading to longer play sessions and higher wager volumes.

### Mystery Jackpot Enabling/Disabling Criteria #39—Dealer Change Event Trigger

Description and Implementation: This enabling criterion activates the Mystery Jackpot when a dealer change occurs at an LDGT. The system is configured to monitor dealer shifts, and when a new dealer takes over the table, the jackpot is automatically triggered for all players currently participating. This feature ties the excitement of a fresh dealer to the chance of winning a significant prize, making dealer changes more engaging for players.

For example, in a blackjack game, the system may trigger the Mystery Jackpot when the dealer is replaced at the end of their shift. Players at the table are notified of the jackpot activation, and they may place side bets to participate in the jackpot during the next round with the new dealer.

Benefits to Players: Players enjoy the added excitement that comes with the start of a new dealer's shift. The connection between a dealer change and the jackpot activation keeps players engaged and eager to stay at the table. Knowing that a dealer change may trigger the jackpot adds anticipation to the gaming experience, making each transition between dealers a moment of heightened interest.

Benefits to Casinos: Casinos benefit from increased player retention, as players are more to remain at the table during dealer changes to take advantage of the jackpot opportunity. This feature encourages continuity of play during shift changes, reducing the chances of players leaving the table. By linking the jackpot to dealer changes, casinos may keep the gaming experience dynamic and ensure that players stay engaged throughout the session.

### Example Walk-Through Scenario:

After playing several rounds of baccarat at an LDGT, the dealer announces that they will be leaving and a new dealer will be taking over. As the dealer change occurs, the system automatically triggers the Mystery Jackpot, notifying all players at the table that the jackpot is now live. The players, excited by the activation, place side bets for the next round.

The new dealer's arrival adds to the anticipation, and the players eagerly continue betting, hoping to win the jackpot during the dealer's first few rounds. The smooth transition between dealers, coupled with the jackpot activation, ensures that players remain engaged and the table stays full.

### Example System Procedural Flow:

1. Dealer Change Monitoring: The system tracks dealer shift changes at LDGTs, recording when a new dealer takes over the table.
2. Dealer Change Detection: When a dealer change occurs, the system triggers the activation of the Mystery Jackpot for all players currently at the table.
3. Jackpot Activation: The system notifies all players that the jackpot is live, allowing them to place side bets during the new dealer's first few rounds.
4. Player Participation: The system logs all side bets and jackpot contributions from the players, ensuring that they have a chance to win the jackpot during the dealer change event.
5. Jackpot Payout and Reset: After the jackpot is won, the system disburses the payout and resets the dealer change tracking for future shifts.

### Noteworthy Aspects and Features:

Dealer-Driven Excitement: This criterion adds excitement to dealer changes, encouraging players to stay at the table and continue betting during transitions between dealers.
Continuous Player Engagement: By activating the jackpot during dealer changes, casinos may reduce player drop-off and ensure that tables remain full during shift changes.
Dynamic Gameplay: The anticipation of a dealer change triggering the jackpot keeps players engaged, making each shift transition a point of interest and excitement.

### Mystery Jackpot Enabling/Disabling Criteria #40—Activation During Casino-Sponsored Charity Events

Description and Implementation: This enabling criterion activates the Mystery Jackpot during casino-sponsored charity events or philanthropic initiatives. The system is programmed to trigger the jackpot during the duration of the event, and a portion of the jackpot contributions may be donated to the charity being supported. The feature adds a charitable aspect to the gaming experience, encouraging players to participate in the jackpot while contributing to a good cause.

For instance, during a charity poker tournament, the Mystery Jackpot may be activated, allowing players to place side bets for a chance to win the jackpot, with part of the proceeds going to the designated charity. This feature aligns the casino's philanthropic efforts with player engagement, creating a positive gaming atmosphere.

Benefits to Players: Players enjoy the opportunity to contribute to a charitable cause while participating in the Mystery Jackpot. The knowledge that part of their jackpot contributions will go to charity adds a sense of purpose to their gaming experience. This feature makes players feel good about participating, as they may potentially win a prize while also supporting a worthy cause.

Benefits to Casinos: Casinos benefit from increased player participation and engagement during charity events, as the jackpot activation encourages more betting activity. This feature enhances the casino's reputation by aligning its gaming activities with charitable initiatives, creating a positive public image. Additionally, casinos may attract new patrons who are drawn to the charitable aspect of the event, leading to increased traffic and revenue.

### Example Walk-Through Scenario:

During a casino-sponsored charity event supporting a local hospital, the system activates the Mystery Jackpot across all LDGTs and ETGTs for the duration of the event. Players are informed that part of the proceeds from their side bets on the jackpot will be donated to the charity. Sarah, participating in a blackjack game, decides to place a side bet for the jackpot, knowing that her contribution will help support the hospital's fundraising efforts.

As the event progresses, more players place side bets on the jackpot, eager to contribute to the charity while also having the chance to win a significant prize. After several rounds, the jackpot is won, and the casino donates a portion of the proceeds to the charity, creating a celebratory atmosphere and reinforcing the positive impact of the event.

### Example System Procedural Flow:

1. Charity Event Scheduling: The casino schedules the charity event and configures the system to activate the Mystery Jackpot during the event's duration.
2. Jackpot Activation: At the start of the charity event, the system triggers the Mystery Jackpot across all participating LDGTs and ETGTs, allowing players to place side bets.
3. Player Participation: Players are notified that part of their jackpot contributions will go to charity. The system logs all side bets and ensures that players have a chance to win the jackpot while supporting the cause.
4. Charitable Contribution: The system allocates a portion of the jackpot contributions to the charity, providing real-time updates on the total amount raised for the cause.
5. Jackpot Payout and Charity Donation: Once the jackpot is won, the system disburses the payout to the winner and donates the designated portion of the proceeds to the charity, reinforcing the philanthropic impact of the event.

### Noteworthy Aspects and Features:

Charitable Engagement: This criterion combines player participation with charitable giving, creating a gaming experience that benefits both players and the community.
Positive Public Image: By aligning the jackpot with charity events, casinos enhance their reputation and attract new patrons who are drawn to the philanthropic aspect of the event.
Increased Participation: Players are more to participate in the jackpot when they know that part of their contributions will go to a good cause, leading to higher engagement and wager volumes during charity events.

### Mystery Jackpot Enabling/Disabling Criteria #41—Activation Based On Player'S Game Preferences

Description and Implementation: This enabling criterion activates the Mystery Jackpot based on a player's individual game preferences, such as the types of games they frequently play or specific betting patterns they follow. The system tracks each player's gaming history and preferences, tailoring the jackpot activation to their preferred games or styles of play. This personalized approach creates a customized gaming experience, offering players jackpot opportunities that align with their unique preferences.

For example, if a player frequently plays baccarat and tends to place large side bets, the system may activate the Mystery Jackpot specifically for baccarat games when that player joins a table or reaches a certain betting threshold. This criterion personalizes the jackpot experience, making it more relevant and engaging for the player.

Benefits to Players: Players benefit from a tailored gaming experience that reflects their individual preferences. By aligning the jackpot activation with their favorite games or betting habits, players feel recognized and valued by the casino. The personalized nature of the Mystery Jackpot activation creates a more engaging and exciting experience for players, as they know their unique gaming preferences are being acknowledged. This sense of customization encourages longer play sessions and higher engagement, as players anticipate jackpot opportunities tailored specifically to them.

Benefits to Casinos: Casinos benefit from increased player retention and loyalty by offering personalized gaming experiences. By tracking player preferences and activating the Mystery Jackpot in response to individual behaviors, casinos may create a more engaging atmosphere that encourages repeat visits. This tailored approach leads to higher wager volumes, as players are motivated to play more when the gaming experience aligns with their preferences. Furthermore, personalized jackpots foster a deeper connection between the player and the casino, enhancing overall player satisfaction and brand loyalty.

### Example Walk-Through Scenario:

Emma is a frequent baccarat player who often places large side bets during her sessions. The casino's system has tracked her preferences over time and recognizes her penchant for high-stakes baccarat. One evening, as Emma sits down at her favorite baccarat table, the system automatically activates the Mystery Jackpot for her, specifically in the context of her favorite game.

A notification appears on her screen, informing her that the jackpot has been tailored to her playing style and is now live. Emma, excited by the personalized jackpot opportunity, places a side bet on the jackpot for the next round. The personalized activation enhances her gaming experience, making her feel appreciated by the casino, and she continues playing, knowing that her preferences have unlocked this exclusive jackpot opportunity.

### Example System Procedural Flow:

1. Player Preference Tracking: The system continuously monitors each player's gaming history, tracking their preferred games and betting patterns across LDGTs and ETGTs.
2. Preference Detection: When a player joins their preferred game or exhibits their usual betting behavior (e.g., large side bets in baccarat), the system identifies these preferences and triggers the activation of the Mystery Jackpot.
3. Personalized Jackpot Activation: The player is notified that the jackpot has been activated specifically based on their gaming preferences, and they may place side bets to participate.
4. Player Participation: The system logs all side bets and contributions to the jackpot pool, ensuring that the player's preferred game is linked to their participation in the jackpot.
5. Jackpot Payout and Reset: Once the jackpot is won, the system disburses the payout and resets the preference tracking for future personalized activations.

### Noteworthy Aspects and Features:

Personalized Engagement: This criterion customizes the gaming experience for each player, ensuring that the jackpot activation aligns with their specific preferences, enhancing engagement and loyalty.
Increased Player Retention: By tailoring jackpot activations to individual players, casinos may encourage longer play sessions and foster stronger relationships with patrons.
Higher Wager Volumes: Players are more to place larger or more frequent bets when they know the jackpot has been activated specifically for their favorite games or betting patterns, leading to increased revenue for the casino.

### Mystery Jackpot Enabling/Disabling Criteria #42—Activation Based On Player's Hot Streak

Description and Implementation: This enabling criterion activates the Mystery Jackpot when a player experiences a hot streak, defined by consecutive wins or a particularly strong winning session. The system monitors each player's performance in real-time, and when a player wins a predefined number of consecutive rounds or achieves significant wins over a short period, the Mystery Jackpot is triggered. This criterion rewards players for their success, creating additional excitement during their hot streak.

For instance, in a blackjack game, the system may activate the Mystery Jackpot after a player wins five rounds in a row, offering them the chance to participate in the jackpot while riding the momentum of their hot streak.

Benefits to Players: Players are rewarded for their success with the opportunity to participate in the Mystery Jackpot, adding an extra layer of excitement to their winning streak. This feature enhances the thrill of consecutive wins, as players feel that their momentum is being recognized and rewarded by the casino. The jackpot activation encourages players to continue betting, knowing that their hot streak may lead to even greater rewards.

Benefits to Casinos: Casinos benefit from extended play sessions, as players are more to continue betting when they are on a hot streak and have the chance to participate in the jackpot. This feature increases wager volumes, as players capitalize on their winning momentum. By recognizing and rewarding successful players, casinos may create a positive and engaging atmosphere that encourages players to stay at the table and keep betting, ultimately driving higher revenue.

### Example Walk-Through Scenario:

John is playing roulette at an ETGT and has been on a hot streak, winning five consecutive rounds. As the system tracks his performance, it detects that John has reached the predefined threshold for consecutive wins. The system automatically triggers the Mystery Jackpot for him, notifying him via an on-screen message that he is now eligible to participate. Excited by the recognition of his hot streak, John places a side bet for the jackpot in the next round of roulette.

The opportunity to capitalize on his hot streak with a potential jackpot win adds to John's excitement and motivates him to continue betting. Other players at the table notice John's success and the jackpot activation, encouraging them to place side bets as well. After a few more rounds, John's luck continues, and he wins the jackpot, further enhancing his winning session.

### Example System Procedural Flow:

1. Player Performance Monitoring: The system tracks each player's performance in real-time, recording consecutive wins or significant victories at LDGTs and ETGTs.
2. Hot Streak Detection: When a player achieves the predefined number of consecutive wins (e.g., five rounds in a row), the system triggers the activation of the Mystery Jackpot for that player.
3. Jackpot Activation: The player is notified that the jackpot is now live, allowing them to place side bets and participate in the jackpot while riding their hot streak.
4. Player Participation: The system logs all side bets and contributions to the jackpot pool, ensuring that the player has an opportunity to win the jackpot based on their successful gameplay.
5. Jackpot Payout and Reset: Once the jackpot is won, the system disburses the payout and resets the hot streak tracking for future sessions.

### Noteworthy Aspects and Features:

Reward for Success: This criterion enhances the gaming experience by recognizing and rewarding players for consecutive wins, keeping the excitement level high.
Extended Play Sessions: Players are more to continue playing when they are on a hot streak and have a chance to win the jackpot, increasing playtime and wager volumes.
Momentum-Based Engagement: The activation of the jackpot during a hot streak creates a sense of momentum, encouraging players to stay engaged and keep betting in the hope of further success.

### Mystery Jackpot Enabling/Disabling Criteria 943—Jackpot Activation for Teamplay

Description and Implementation: This enabling criterion triggers the Mystery Jackpot when players participate in team-based or cooperative games, where success is measured collectively rather than individually. The system monitors the performance of all team members and activates the jackpot when the team achieves a significant milestone, such as winning a certain number of rounds together or reaching a predefined score as a group. This feature fosters collaboration and teamwork, creating a shared goal for all players involved.

For example, in a team-based poker game, the system may activate the Mystery Jackpot when a team wins five consecutive hands as a group. The jackpot is then available for all team members to participate in, enhancing the collaborative aspect of the game.

Benefits to Players: Players experience the excitement of working together toward a common goal, with the opportunity to share in the rewards of the Mystery Jackpot. The team-based nature of this feature encourages camaraderie and collective strategy, making the gaming experience more social and enjoyable. Players are motivated to perform well not only for themselves but also for their teammates, knowing that their collective efforts may trigger the jackpot.

Benefits to Casinos: Casinos benefit from increased player engagement and longer play sessions, as team-based games encourage players to stay at the table and work together to achieve milestones. This feature also fosters a social atmosphere on the gaming floor, attracting players who enjoy collaborative gameplay. By offering team-based jackpot activations, casinos may differentiate their gaming experience and appeal to a broader range of players, ultimately driving higher wager volumes.

### Example Walk-Through Scenario:

A group of four players is participating in a team-based poker game at an LDGT. The system is configured to activate the Mystery Jackpot when the team wins five consecutive rounds as a group. After a series of intense rounds, the team successfully wins their fifth consecutive hand, and the system automatically triggers the jackpot for all team members.

The players receive notifications on their screens, informing them that the jackpot is now live and available for their team. Each player places a side bet for the next round, excited by the opportunity to win the jackpot together. The collaborative nature of the game enhances the excitement, as the players work together to win the jackpot while continuing to perform well as a team.

### Example System Procedural Flow:

1. Team Performance Monitoring: The system tracks the collective performance of teams in team-based games, monitoring milestones such as consecutive wins or group scores.
2. Milestone Detection: When a team reaches the predefined milestone (e.g., five consecutive wins), the system triggers the activation of the Mystery Jackpot for all team members.
3. Jackpot Activation: The team is notified that the jackpot is now live, and all members may place side bets to participate in the jackpot for the next round.
4. Player Participation: The system logs all side bets and contributions to the jackpot pool, ensuring that all team members have an equal chance to win the jackpot.
5. Jackpot Payout and Reset: Once the jackpot is won, the system disburses the payout to the winning team members and resets the team performance tracking for future games.

### Noteworthy Aspects and Features:

Collaborative Gameplay: This criterion encourages teamwork and collective strategy, making the gaming experience more social and enjoyable for players.
Shared Rewards: Players are motivated to perform well as a team, knowing that their collective efforts may lead to a jackpot win for all members.
Extended Engagement: The team-based nature of the jackpot activation encourages players to stay at the table longer, leading to increased playtime and higher wager volumes for the casino.

### Mystery Jackpot Enabling/Disabling Criteria 944—Player Reaching a Specific Bet Amount in a Session

Description and Implementation: This enabling criterion activates the Mystery Jackpot when a player reaches a predefined cumulative bet amount during a single gaming session. The system tracks each player's total wagered amount in real-time across all rounds and bets placed during their session at LDGTs (Live Dealer Game Tables) and ETGTs (Electronic Table Game Terminals). Once a player's cumulative wagers exceed the specified threshold (e.g., $5,000 or $10,000), the jackpot becomes available for that player. This feature rewards players who consistently place larger bets or play for extended periods, offering them an exclusive opportunity to participate in the jackpot.

For example, in a blackjack session, the Mystery Jackpot may be triggered when a player's total wagers exceed $10,000. The player is then notified that they are eligible to place side bets on the jackpot during future rounds, allowing them to participate in the chance to win the jackpot.

Benefits to Players: Players who prefer high-stakes play are rewarded for their consistent betting, adding an extra incentive to continue wagering. The cumulative nature of this criterion encourages longer play sessions, as players know that their continued betting may unlock exclusive jackpot opportunities. This feature gives players a tangible goal to work towards, making the session more engaging and rewarding as their total bet amount increases.

Benefits to Casinos: Casinos benefit from increased wager volumes as players are incentivized to place larger bets or extend their playtime to reach the cumulative threshold that activates the jackpot. This feature encourages high-rollers and consistent bettors to stay engaged, driving higher revenue for the casino. By offering jackpot opportunities tied to total bet amounts, casinos may foster loyalty among high-value players who feel recognized for their consistent participation.

### Example Walk-Through Scenario:

Mark, a regular baccarat player, has been placing large bets throughout his session. As the system tracks his wagers, Mark's total bet amount gradually approaches $10,000. After placing another high-stakes bet, the system recognizes that Mark has reached the cumulative threshold and activates the Mystery Jackpot for him. A notification appears on Mark's screen, informing him that he is now eligible to place side bets on the jackpot in the next round.

Excited by this milestone, Mark places a side bet on the jackpot during the next hand. The activation of the jackpot motivates Mark to continue playing, knowing that his consistent high-stakes bets have unlocked this exclusive opportunity. The added excitement of the jackpot keeps Mark engaged, and he continues placing large bets throughout the session.

### Example System Procedural Flow:

1. Wager Tracking: The system tracks the total amount wagered by each player during their session at LDGTs and ETGTs, updating the cumulative total after each bet.
2. Threshold Detection: When a player's cumulative wagers exceed the predefined threshold (e.g., $10,000), the system triggers the activation of the Mystery Jackpot for that player.
3. Jackpot Activation: The player is notified that the jackpot is now live, and they may place side bets to participate in the jackpot during future rounds.
4. Player Participation: The system logs all side bets and contributions to the jackpot pool, ensuring that the player's cumulative wagering activity is linked to their participation in the jackpot.
5. Jackpot Payout and Reset: After the jackpot is won, the system disburses the payout and resets the cumulative wager tracking for future sessions.

### Noteworthy Aspects and Features:

High-Roller Incentive: This criterion rewards players who consistently place large bets, encouraging high-stakes play and fostering longer engagement.
Cumulative Reward: Players are motivated to stay engaged and continue betting, knowing that their cumulative wagers will unlock exclusive jackpot opportunities.
Increased Wager Volumes: Casinos benefit from higher wager volumes as players work towards reaching the cumulative threshold that triggers the jackpot.

### Mystery Jackpot Enabling/Disabling Criteria #45—Activation for Special Anniversary or Milestone Events

Description and Implementation: This enabling criterion activates the Mystery Jackpot during special anniversary events or casino milestones, such as the casino's anniversary, a player's birthday, or the anniversary of a player's membership in the loyalty program. The system is programmed to trigger the jackpot during these celebratory occasions, offering players exclusive opportunities to participate in the jackpot during the event. This feature adds a personalized and festive element to the gaming experience, encouraging players to engage more during special milestones.

For example, the Mystery Jackpot may be activated for players on their birthday, allowing them to place side bets on the jackpot throughout the day. Similarly, the casino may activate the jackpot for all players during its annual anniversary celebration, creating a festive atmosphere that encourages participation.

Benefits to Players: Players enjoy the personalized and celebratory nature of this feature, as the activation of the jackpot during special events makes them feel recognized and appreciated. Whether it's their birthday, a membership anniversary, or a casino milestone, the opportunity to participate in the jackpot adds excitement and significance to their gaming session. This feature enhances player loyalty and engagement, as players look forward to special events that offer exclusive rewards.

Benefits to Casinos: Casinos benefit from increased player traffic and engagement during special events, as the activation of the Mystery Jackpot encourages more participation. By aligning jackpot opportunities with notable milestones or anniversaries, casinos may create a festive atmosphere that attracts both new and returning players. This feature fosters player loyalty, as patrons feel valued and are more to return for future events that offer similar rewards.

### Example Walk-Through Scenario:

On the day of his birthday, Daniel visits the casino to celebrate. As soon as he logs in at an ETGT, the system recognizes the special occasion and activates the Mystery Jackpot as a birthday bonus. A notification appears on Daniel's screen, congratulating him on his birthday and informing him that the jackpot is now live.

Excited by the personalized reward, Daniel places a side bet on the jackpot for the next round of blackjack. The birthday activation makes Daniel's gaming session feel more festive, and he continues placing side bets on the jackpot throughout the day. The personalized nature of the jackpot adds to Daniel's enjoyment, making his birthday celebration at the casino more memorable.

### Example System Procedural Flow:

1. Event Detection: The system tracks special events such as player birthdays, membership anniversaries, or casino milestones, identifying eligible occasions for jackpot activation.
2. Special Event Recognition: When the system recognizes a qualifying event (e.g., a player's birthday), it triggers the activation of the Mystery Jackpot for the player or for all participants during a casino-wide event.
3. Jackpot Activation: The player is notified that the jackpot is live, and they may place side bets to participate in the jackpot during the event.
4. Player Participation: The system logs all side bets and contributions to the jackpot pool, ensuring that the player's participation is linked to the special event.
5. Jackpot Payout and Event Reset: After the jackpot is won, the system disburses the payout and resets the special event tracking for future milestone activations.

### Noteworthy Aspects and Features:

Personalized Celebrations: This criterion enhances the gaming experience by recognizing players during special events, making them feel valued and appreciated.
Increased Engagement: Players are more to visit the casino and participate in the jackpot during special events, leading to higher player traffic and wager volumes.
Festive Atmosphere: The activation of the jackpot during anniversaries or milestone events creates a celebratory atmosphere that encourages participation and enhances the overall casino experience.

### Mystery Jackpot Enabling/Disabling Criteria #46—Activation Linked to Slot Machine Jackpot Wins

Description and Implementation: This enabling criterion activates the Mystery Jackpot when a major jackpot is won on one of the slot machines in the casino. The system monitors slot machine activity across the casino floor, and when a significant jackpot is hit, the Mystery Jackpot is triggered for players at LDGTs and ETGTs. This feature ties the excitement of a slot machine win to the activation of the jackpot in table games, creating a shared sense of celebration and opportunity across the gaming floor.

For example, when a player wins a progressive jackpot on a slot machine, the system may trigger the Mystery Jackpot at all baccarat tables, allowing players to place side bets and participate in the jackpot in response to the slot win.

Benefits to Players: Players at table games benefit from the excitement generated by a slot machine jackpot win, as the activation of the Mystery Jackpot adds an unexpected reward to their gaming session. The link between slot machine wins and table game jackpots creates a sense of shared excitement across the casino floor, keeping players engaged and motivated to continue betting. This feature also adds variety to the gaming experience, as players at table games know that major wins elsewhere in the casino may lead to their own jackpot opportunities.

Benefits to Casinos: Casinos benefit from increased player engagement and wager volumes, as players at table games are incentivized to stay and participate in the Mystery Jackpot when a major slot machine win occurs. This feature helps keep the entire gaming floor engaged, as the excitement of a slot win extends beyond the slot machines and into other areas of the casino. By linking slot machine and table game jackpots, casinos may create a more dynamic and interconnected gaming environment, driving higher overall participation.

### Example Walk-Through Scenario:

A player at a nearby slot machine hits the progressive jackpot, winning a significant prize. As soon as the win is registered, the casino's system activates the Mystery Jackpot for all baccarat tables, including the one where Sarah is playing. A notification appears on Sarah's screen, informing her that the Mystery Jackpot has been activated in response to the slot machine win.

Excited by the unexpected opportunity, Sarah places a side bet on the jackpot for the next round of baccarat. The shared excitement on the gaming floor creates a celebratory atmosphere, and players across multiple tables place side bets on the jackpot, hoping to win their own share of the excitement. Sarah, along with other players at various tables, is motivated to continue playing, knowing that the Mystery Jackpot was activated by an event on the casino floor. This link between a major slot win and the Mystery Jackpot adds a communal element to the experience, keeping everyone at the tables engaged.

### Example System Procedural Flow:

1. Slot Machine Jackpot Monitoring: The system continuously monitors slot machine activity across the casino, tracking when a major jackpot is won.
2. Slot Jackpot Detection: When a player hits a significant jackpot on a slot machine, the system identifies the win and triggers the activation of the Mystery Jackpot for table game players.
3. Jackpot Activation: All players at LDGTs and ETGTs are notified that the Mystery Jackpot has been activated in response to the slot machine win, allowing them to place side bets in the following rounds.
4. Player Participation: The system logs side bets and contributions to the jackpot pool, ensuring all players have a chance to win the Mystery Jackpot based on the slot machine event.
5. Jackpot Payout and Reset: After the Mystery Jackpot is won, the system disburses the payout and resets tracking for future slot machine jackpots that may trigger the feature again.

### Noteworthy Aspects and Features:

Shared Excitement: This criterion links the thrill of slot machine wins to table games, spreading excitement across the gaming floor and engaging a broader group of players.
Cross-Game Engagement: Casinos benefit from increased participation across different areas of the casino, as slot machine wins boost activity at table games through the Mystery Jackpot.
Surprise Factor: The unexpected activation of the Mystery Jackpot in response to external wins adds a layer of unpredictability, keeping players engaged and increasing wager volumes.

### Mystery Jackpot Enabling/Disabling Criteria #47—Activation for Reaching Table Minimum Bet Threshold

Description and Implementation: This enabling criterion activates the Mystery Jackpot when a player places a bet that meets or exceeds the table's minimum bet threshold for a set number of consecutive rounds. The system tracks each player's bets at LDGTs and ETGTs, and once a player consistently places bets above the minimum threshold (e.g., for five consecutive rounds), the jackpot is triggered. This criterion rewards players who maintain steady betting patterns, especially at tables with higher minimum bets.

For instance, in a blackjack game with a $100 minimum bet, the Mystery Jackpot may be triggered when a player places at least five consecutive bets of $100 or more. The player is then eligible to participate in the jackpot for the next round, adding an extra layer of reward for consistent betting.

Benefits to Players: Players are incentivized to place consistent bets above the table minimum, knowing that doing so may unlock the Mystery Jackpot. This criterion rewards players for maintaining steady wagers, adding a goal to their gameplay. The activation of the jackpot for meeting this criterion gives players a sense of accomplishment and encourages them to stay engaged in the game longer.

Benefits to Casinos: Casinos benefit from increased wager volumes as players strive to meet the minimum bet threshold in consecutive rounds. This criterion encourages consistent betting behavior, especially at tables with higher minimums, which drives overall revenue. By rewarding steady play, casinos create a more engaging environment where players feel motivated to continue participating in the game.

### Example Walk-Through Scenario:

James is playing baccarat at an ETGT with a minimum bet of $200. He consistently places $200 bets for five consecutive rounds, meeting the table's threshold. As soon as James places his fifth bet, the system detects his consistent wagering and activates the Mystery Jackpot for him. A notification appears on his screen, informing him that he is now eligible to place a side bet on the jackpot.

Excited by the reward for his consistent betting, James places a side bet for the next round, adding another layer of excitement to his game. The opportunity to win the jackpot motivates James to continue placing steady bets, ensuring that his engagement remains high throughout the session.

### Example System Procedural Flow:

1. Bet Monitoring: The system tracks the amount of each player's bet in real-time, identifying when consecutive bets meet or exceed the table's minimum bet threshold.
2. Threshold Detection: When a player places a predefined number of consecutive bets (e.g., five rounds) that meet or exceed the minimum bet, the system triggers the activation of the Mystery Jackpot.
3. Jackpot Activation: The player is notified that the jackpot is now live, and they may place side bets to participate in the jackpot during future rounds.
4. Player Participation: The system logs all side bets and contributions to the jackpot pool, ensuring that the player has a chance to win the jackpot based on their consistent betting.
5. Jackpot Payout and Reset: After the jackpot is won, the system disburses the payout and resets the bet threshold tracking for future activations.

### Noteworthy Aspects and Features:

Incentive for Steady Play: This criterion rewards players who maintain consistent betting patterns, encouraging longer play sessions and higher wager volumes.
Increased Table Activity: Casinos benefit from the increased engagement of players who consistently bet at or above the table minimum, driving higher revenues.
Player Retention: The activation of the jackpot for steady betting encourages players to remain at the table and continue placing bets, improving player retention.

### Mystery Jackpot Enabling/Disabling Criteria #48—Activation for Consecutive Draws or Ties

Description and Implementation: This enabling criterion activates the Mystery Jackpot when a certain number of consecutive draws or ties occur in games like baccarat or poker. The system monitors game outcomes and, when a predefined number of draws or ties occur in a row, the jackpot is triggered for all players at the table. This feature adds excitement to games where draws or ties are typically seen as neutral outcomes, turning them into opportunities for players to win the jackpot.

For example, in baccarat, the system may be configured to activate the Mystery Jackpot after three consecutive tie outcomes. Players at the table are then notified of the jackpot activation and given the opportunity to place side bets in the following rounds.

Benefits to Players: Players are given an exciting new reason to hope for draws or ties, which are normally seen as uneventful game outcomes. The possibility of activating the Mystery Jackpot during a string of ties adds an unexpected twist to the game and keeps players engaged even during rounds where no definitive winner emerges. This feature enhances the excitement and rewards players for sticking through these neutral outcomes.

Benefits to Casinos: Casinos benefit from increased player engagement, as players are motivated to remain at the table and continue betting through a string of ties, knowing that the jackpot may be triggered. This feature helps retain players during less exciting moments of the game, ensuring that they continue placing bets even during neutral outcomes. The additional excitement generated by the jackpot activation also drives higher overall wager volumes.

### Example Walk-Through Scenario:

During a baccarat session at an LDGT, the game results in three consecutive ties. The system detects the sequence of ties and automatically triggers the Mystery Jackpot for all players at the table. A notification appears on the players' screens, informing them that the jackpot has been activated due to the string of tie outcomes.

The players, excited by this unexpected development, place side bets on the jackpot for the next round. The jackpot activation turns what may have been a series of uneventful outcomes into a thrilling opportunity for all participants, keeping everyone engaged and motivated to continue playing.

### Example System Procedural Flow:

1. Outcome Monitoring: The system tracks game results in real-time, logging ties or draws in games like baccarat or poker.
2. Consecutive Tie Detection: When a predefined number of consecutive ties or draws occur (e.g., three in a row), the system triggers the activation of the Mystery Jackpot for all players at the table.
3. Jackpot Activation: Players are notified that the jackpot is now live, and they may place side bets during the next round.
4. Player Participation: The system logs all side bets and contributions to the jackpot pool, ensuring that all players have an equal chance to win the jackpot based on the tie outcomes.
5. Jackpot Payout and Reset: After the jackpot is won, the system disburses the payout and resets the tie tracking for future activations.

### Noteworthy Aspects and Features:

Neutral Outcome Excitement: This criterion adds excitement to normally neutral game outcomes, encouraging players to remain engaged during ties or draws.
Increased Player Retention: By making draws or ties more exciting, casinos may keep players engaged during slower moments of the game, driving higher wager volumes.
Dynamic Gameplay: The activation of the jackpot during tie sequences adds a new layer of unpredictability to the game, keeping players motivated to continue betting.

### Mystery Jackpot Enabling/Disabling Criteria #49—Activation for Bets On Low Probability Outcomes

Description and Implementation: This enabling criterion activates the Mystery Jackpot when a player places a bet on a low-probability outcome, such as betting on a specific combination in poker, a rare number in roulette, or an unlikely result in baccarat. The system tracks each player's bets and, when a low-probability outcome is wagered on, the jackpot is triggered for that player, offering them an additional opportunity to win. This feature rewards players for taking risks on unlikely outcomes, adding excitement to high-risk betting strategies.

For example, in roulette, the system may trigger the Mystery Jackpot when a player places a bet on a specific number that has a low probability of winning. If the bet is placed, the player is immediately eligible to participate in the jackpot, regardless of the bet's outcome.

Benefits to Players: Players who enjoy taking risks are rewarded for betting on low-probability outcomes with the opportunity to participate in the Mystery Jackpot. This feature adds an extra layer of excitement to betting on unlikely results, giving players an incentive to try bold strategies. Even if their initial bet doesn't win, the activation of the jackpot gives them another chance to earn a significant prize, making riskier bets more appealing and potentially more rewarding.

Benefits to Casinos: Casinos benefit from increased wager volumes as players are encouraged to place more high-risk bets in pursuit of both their original win and the possibility of unlocking the jackpot. By offering rewards for betting on unlikely outcomes, casinos may create a more dynamic gaming environment that encourages players to try new strategies and stay engaged longer. This feature attracts players who enjoy high-risk, high-reward betting, driving more diverse types of wagers across the casino floor.

### Example Walk-Through Scenario:

In a game of roulette, John decides to place a high-risk bet on the number 17, a low-probability outcome with a significant payout. As soon as he places his bet, the system recognizes the wager on this rare result and activates the Mystery Jackpot for John. A notification appears on his screen, informing him that the jackpot is now live and that he may place side bets for the next round.

Even though John's number doesn't win in that round, the excitement of having the jackpot activated keeps him engaged in the game. He places a side bet on the jackpot and continues playing, excited by the possibility of winning the jackpot in addition to his future roulette bets.

### Example System Procedural Flow:

1. Bet Monitoring: The system tracks all bets placed at LDGTs and ETGTs in real-time, identifying when a player wagers on a low-probability outcome.
2. Probability Detection: When the system detects that a player has placed a bet on a low-probability outcome (e.g., betting on a specific number in roulette), it triggers the activation of the Mystery Jackpot.
3. Jackpot Activation: The player is notified that the jackpot is now live, and they may place side bets during subsequent rounds.
4. Player Participation: The system logs all side bets and contributions to the jackpot pool, ensuring that the player has a chance to win the jackpot based on their initial high-risk bet.
5. Jackpot Payout and Reset: After the jackpot is won, the system disburses the payout and resets the tracking of low-probability bets for future activations.

### Noteworthy Aspects and Features:

Risk-Reward Dynamics: This criterion enhances the excitement of betting on low-probability outcomes by offering additional rewards, encouraging players to place bolder wagers.
Increased Betting Variety: Casinos benefit from more diverse wagers as players experiment with high-risk strategies in pursuit of the jackpot.
Engaged High-Risk Players: The activation of the jackpot for low-probability bets keeps high-risk players engaged and motivated to continue betting.

### Mystery Jackpot Enabling/Disabling Criteria #50—Activation Based on Session Duration

Description and Implementation: This enabling criterion triggers the Mystery Jackpot based on the duration of a player's gaming session. The system monitors the length of time each player spends at the table or terminal and, once a player's session surpasses a predefined duration (e.g., two hours), the jackpot is activated for them. This feature rewards players for extended play and encourages them to remain engaged in the game over longer periods, knowing that they will eventually become eligible for the jackpot.

For example, in a blackjack session, the Mystery Jackpot may be triggered once a player's session surpasses two hours. The player is then notified that the jackpot is available, allowing them to place side bets and participate in the jackpot as a reward for their extended playtime.

Benefits to Players: Players are rewarded for their commitment and engagement with the game through the activation of the Mystery Jackpot based on session duration. This criterion provides players with a goal to work towards, knowing that if they stay at the table long enough, they will be eligible for the jackpot. The feature enhances the experience of extended play sessions, offering additional rewards to players who remain committed over time.

Benefits to Casinos: Casinos benefit from increased player retention and longer play sessions, as players are incentivized to stay engaged in the game for extended periods in order to qualify for the jackpot. This feature helps casinos maximize the time players spend at the table or terminal, leading to higher wager volumes and overall revenue. By offering a time-based jackpot activation, casinos may encourage players to remain at the casino longer, improving both engagement and profitability.

### Example Walk-Through Scenario:

Emily has been playing at a baccarat table for nearly two hours. The system tracks her session duration in real-time, and as she surpasses the two-hour mark, the Mystery Jackpot is automatically triggered for her. A notification appears on her screen, congratulating her for reaching the session duration milestone and informing her that the jackpot is now live.

Excited by the reward for her extended play, Emily places a side bet on the jackpot for the next round. The activation of the jackpot based on her session duration motivates her to continue playing, knowing that her long session has led to this exclusive opportunity.

### Example System Procedural Flow:

1. Session Duration Monitoring: The system tracks each player's session duration at LDGTs and ETGTs, updating the total time spent in real-time.
2. Duration Threshold Detection: When a player's session surpasses the predefined duration (e.g., two hours), the system triggers the activation of the Mystery Jackpot for that player.
3. Jackpot Activation: The player is notified that the Mystery Jackpot is now live, and they are eligible to place side bets to participate in the jackpot during future rounds.
4. Player Participation: The system logs all side bets and contributions to the jackpot pool, ensuring that the player has a chance to win the jackpot based on their extended session duration.
5. Jackpot Payout and Reset: After the jackpot is won, the system disburses the payout and resets the session duration tracking for future activations.

### Noteworthy Aspects and Features:

Reward for Longevity: This criterion encourages longer play sessions by offering players a reward for their extended engagement with the game.
Increased Retention: Players are more to stay at the table or terminal longer when they know that continued play will eventually make them eligible for the jackpot.
Higher Wager Volumes: By incentivizing players to remain engaged over long periods, casinos benefit from increased wager volumes and improved player retention.

### Mystery Jackpot Enabling/Disabling Criteria #51—Activation During Bonus Rounds or Features

Description and Implementation: This enabling criterion activates the Mystery Jackpot during bonus rounds or special game features, such as free spins in slot games or bonus hands in card games. The system tracks when a player enters a bonus round or activates a special feature, and the jackpot is triggered for the player at that moment. This feature adds an extra layer of excitement to bonus rounds, making them even more rewarding by offering players the chance to win the jackpot.

For example, in a blackjack game, the system may trigger the Mystery Jackpot when a player activates a bonus hand. Similarly, in a slot game, the jackpot may be activated when a player enters a free spin round. This adds an additional reward to an already favorable outcome, enhancing the overall gaming experience.

Benefits to Players: Players experience heightened excitement during bonus rounds or special features, knowing that the Mystery Jackpot may also be activated. This feature makes bonus rounds more thrilling, as players are not only receiving a bonus but also have a chance to win a jackpot. The combination of a bonus and a jackpot adds significant value to the game, keeping players engaged and motivated to pursue these special features.

Benefits to Casinos: Casinos benefit from increased player participation and engagement, as players are incentivized to pursue bonus rounds and special features that may lead to a jackpot activation. This feature drives more consistent play, as players seek to trigger the bonus rounds that offer enhanced rewards. By linking the jackpot to bonus features, casinos may keep players engaged for longer periods, leading to higher wager volumes and more exciting gameplay.

### Example Walk-Through Scenario:

At a blackjack table, Sophie manages to activate a bonus hand, which allows her to double her potential winnings. As soon as she enters the bonus hand, the system automatically triggers the Mystery Jackpot, and a notification appears on her screen, informing her that she is now eligible to place a side bet on the jackpot.

Excited by this unexpected opportunity, Sophie places a side bet on the jackpot during her bonus round, adding another layer of excitement to her already favorable situation. The combination of the bonus hand and the activated jackpot keeps Sophie engaged, and she continues playing in hopes of triggering additional features that may lead to further jackpot opportunities.

### Example System Procedural Flow:

1. Bonus Round Monitoring: The system tracks when a player enters a bonus round or activates a special game feature, such as a free spin or bonus hand.
2. Bonus Round Detection: When a player triggers a bonus round or special feature, the system identifies the event and activates the Mystery Jackpot for that player.
3. Jackpot Activation: The player is notified that the jackpot is now live, and they may place side bets during the bonus round or in the following rounds.
4. Player Participation: The system logs all side bets and contributions to the jackpot pool, ensuring that the player has a chance to win the jackpot based on their bonus round performance.
5. Jackpot Payout and Reset: After the jackpot is won, the system disburses the payout and resets the bonus round tracking for future activations.

### Noteworthy Aspects and Features:

Enhanced Bonus Rounds: This criterion increases the excitement of bonus rounds or special features by offering players the additional chance to win the Mystery Jackpot.
Increased Player Motivation: Players are more motivated to seek out bonus rounds and special features, knowing that these events may lead to a jackpot activation.
Higher Engagement: By linking the jackpot to bonus rounds, casinos may drive longer play sessions and higher wager volumes, as players aim to unlock these special rewards.

### Mystery Jackpot Enabling/Disabling Criteria #52—Activation Based on Player Achieving a Personal Best

Description and Implementation: This enabling criterion triggers the Mystery Jackpot when a player achieves a personal best in a specific game, such as reaching their highest score in poker or recording their longest winning streak in blackjack. The system tracks each player's performance over time and activates the jackpot when they surpass a predefined personal milestone. This feature adds an element of achievement to the gaming experience, rewarding players for setting new personal records.

For example, in a poker session, the Mystery Jackpot may be activated when a player surpasses their previous best hand score. Similarly, in blackjack, the jackpot may be triggered when a player records their longest winning streak.

Benefits to Players: Players feel rewarded for their achievements, as the activation of the Mystery Jackpot adds significance to their personal milestones. The recognition of personal bests creates a sense of accomplishment and encourages players to strive for continuous improvement in their gameplay. This feature enhances the player's engagement, as they are motivated to pursue new personal records and the associated jackpot opportunities.

Benefits to Casinos: Casinos benefit from increased player retention, as players are incentivized to continue playing in pursuit of personal bests that may activate the Mystery Jackpot. This feature encourages players to stay engaged over longer periods, as they aim to surpass their previous records and earn the associated rewards. By offering a personalized jackpot experience based on individual achievements, casinos may foster loyalty and keep players coming back to improve their performance.

### Example Walk-Through Scenario:

During a blackjack session at an ETGT, Michael records his longest winning streak of five consecutive hands. The system, which tracks his personal performance over time, recognizes that he has set a new personal best and activates the Mystery Jackpot in response. A notification appears on Michael's screen, congratulating him on his achievement and informing him that the jackpot is now live.

Michael, excited by the recognition of his new personal best, places a side bet on the jackpot during the next round. The personalized nature of the jackpot activation keeps Michael motivated to continue playing, as he looks to set new records and unlock additional jackpot opportunities in the future.

### Example System Procedural Flow:

1. Player Performance Monitoring: The system tracks each player's performance metrics, such as high scores, winning streaks, and other personal milestones.
2. Personal Best Detection: When a player surpasses a predefined personal best (e.g., longest winning streak or highest score), the system activates the Mystery Jackpot for that player.
3. Jackpot Activation: The player is notified that the jackpot is now live, and they may place side bets during subsequent rounds to participate.
4. Player Participation: The system logs all side bets and contributions to the jackpot pool, ensuring that the player's personal best is linked to their chance of winning the jackpot.
5. Jackpot Payout and Reset: After the jackpot is won, the system disburses the payout and resets the personal best tracking for future milestones.

### Noteworthy Aspects and Features:

Personalized Recognition: This criterion rewards players for achieving personal bests, adding a sense of accomplishment and motivation to their gaming experience.
Extended Play Sessions: Players are encouraged to stay engaged longer as they pursue personal records that may trigger the Mystery Jackpot.
Player Loyalty: By recognizing individual achievements, casinos may foster loyalty and create a personalized gaming experience that keeps players returning to surpass their previous milestones.

### Mystery Jackpot Enabling/Disabling Criteria #53—Activation for Multi-Table Play

Description and Implementation: This enabling criterion activates the Mystery Jackpot for players who are simultaneously participating in multiple tables or games. The system tracks each player's activity across various games and triggers the jackpot when they meet a predefined threshold, such as playing at three or more tables concurrently. This feature rewards players who engage in multi-table or multi-game play, adding an extra layer of excitement to their diversified gaming experience.

For example, if a player is simultaneously playing poker, baccarat, and roulette, the system may activate the Mystery Jackpot once the player has placed bets on all three tables, providing them with an additional reward for their multi-game activity.

Benefits to Players: Players who enjoy playing multiple games simultaneously are rewarded for their broader engagement with the casino's offerings. The activation of the Mystery Jackpot during multi-table play adds an extra incentive for players to diversify their gaming activities, knowing that engaging in multiple games simultaneously may unlock additional rewards. This feature enhances the excitement and complexity of multi-game play, as players are not only focusing on individual game outcomes but also on the possibility of triggering the jackpot by playing across several tables.

Benefits to Casinos: Casinos benefit from increased player engagement and higher overall wager volumes, as players are incentivized to participate in multiple games at once. This criterion encourages cross-game interaction and drives more active play across the casino floor. By offering rewards for multi-table participation, casinos may maximize the use of their gaming tables and terminals, creating a dynamic and fast-paced gaming environment that appeals to players seeking a more intense experience.

### Example Walk-Through Scenario:

Jessica enjoys playing multiple games at once and has bets placed on three different tables: blackjack, roulette, and baccarat. As she navigates between the tables, the system tracks her multi-game activity. Once she has placed bets on all three games, the system recognizes her multi-table play and triggers the Mystery Jackpot for her.

A notification appears on Jessica's screen, informing her that the jackpot has been activated due to her participation across multiple games. Excited by the opportunity, Jessica places side bets on the jackpot for each of the games she's playing. The multi-table activation adds an additional layer of excitement to her already diverse gaming experience, keeping her engaged and motivated to continue playing across all tables.

### Example System Procedural Flow:

1. Multi-Game Activity Monitoring: The system tracks each player's participation across different games, monitoring how many tables or games they are playing simultaneously.
2. Multi-Table Threshold Detection: When a player places bets on a predefined number of games (e.g., three or more), the system triggers the activation of the Mystery Jackpot for that player.
3. Jackpot Activation: The player is notified that the jackpot is now live, and they may place side bets to participate in the jackpot at any of the games they are currently playing.
4. Player Participation: The system logs all side bets and contributions to the jackpot pool, ensuring that the player's multi-table play is linked to their participation in the jackpot.
5. Jackpot Payout and Reset: After the jackpot is won, the system disburses the payout and resets the multi-game tracking for future activations.

### Noteworthy Aspects and Features:

Cross-Game Excitement: This criterion rewards players for participating in multiple games simultaneously, creating a fast-paced and exciting gaming experience.
Increased Wager Volumes: Casinos benefit from the increased betting activity associated with multi-game play, as players are encouraged to place bets across several tables.
Player Retention: The activation of the jackpot during multi-table play encourages players to remain engaged in several games, leading to longer play sessions and greater player retention.

### Mystery Jackpot Enabling/Disabling Criteria #54—Activation for Team Play Achievements

Description and Implementation: This enabling criterion triggers the Mystery Jackpot when a team of players achieves a collective milestone, such as winning a certain number of hands as a group or reaching a combined score in games like poker or blackjack. The system tracks team-based performance and activates the jackpot when the team meets or exceeds the predefined goal. This feature promotes collaborative play, encouraging players to work together to unlock the jackpot.

For example, in a team-based poker session, the system may activate the Mystery Jackpot when the team wins a set number of hands collectively. All team members are then eligible to participate in the jackpot, adding an additional reward for their teamwork.

Benefits to Players: Players enjoy the collaborative nature of this feature, as they are rewarded for working together to achieve a shared goal. The activation of the Mystery Jackpot for team play adds excitement to group sessions, as players know that their collective efforts may lead to significant rewards. This criterion fosters camaraderie and enhances the social aspect of the gaming experience, making it more engaging and enjoyable for everyone involved.

Benefits to Casinos: Casinos benefit from increased player interaction and retention, as team-based play encourages groups of players to stay engaged for longer periods. The collaborative nature of this feature keeps players motivated to participate, knowing that their team's performance may lead to a jackpot activation. By promoting teamwork, casinos create a more dynamic and social environment that encourages repeat visits and higher wager volumes.

### Example Walk-Through Scenario:

At a team-based poker table, four players are working together to win as many hands as possible. The system tracks the team's progress, and after they win five consecutive hands as a group, the Mystery Jackpot is automatically triggered for all team members. A notification appears on each player's screen, informing them that the jackpot has been activated due to their collective performance.

The players, excited by the activation, each place side bets on the jackpot for the next round. The team's success not only enhances their individual gameplay experiences but also deepens their sense of camaraderie, knowing that their collective efforts have unlocked the Mystery Jackpot. The excitement of the jackpot encourages them to continue working together and placing bets, as they aim for further successes and potentially another jackpot activation.

### Example System Procedural Flow:

1. Team Performance Monitoring: The system tracks the progress of teams at LDGTs and ETGTs, monitoring their collective wins or other predefined milestones.
2. Team Milestone Detection: When the team reaches the predefined goal (e.g., winning a set number of hands), the system triggers the activation of the Mystery Jackpot for all team members.
3. Jackpot Activation: All team members are notified that the jackpot is now live, and they may place side bets during the next rounds to participate in the jackpot.
4. Player Participation: The system logs side bets and contributions from all team members, ensuring that everyone has an equal chance to win the jackpot based on their team's success.
5. Jackpot Payout and Reset: Once the jackpot is won, the system disburses the payout to the winning players and resets the team milestone tracking for future games.

### Noteworthy Aspects and Features:

Team-Based Excitement: This criterion rewards players for working together as a team, fostering a collaborative and enjoyable gaming experience.
Increased Group Engagement: Players are motivated to continue playing as a team, knowing that their collective efforts may lead to significant rewards, keeping everyone engaged.
Social Interaction: Casinos benefit from creating a social, dynamic environment where players interact and work together, leading to longer play sessions and higher wager volumes.

### Mystery Jackpot Enabling/Disabling Criteria #55—Activation for “Last Man Standing” Situations

Description and Implementation: This enabling criterion activates the Mystery Jackpot when a player is the last remaining participant at a table or when they are the only player to continue betting through a certain number of rounds. The system detects when all other players have left or stopped betting, and the remaining player is rewarded with the activation of the Mystery Jackpot. This feature encourages players to stay at the table even as others leave, turning a “last man standing” situation into a rewarding opportunity.

For example, in a poker game where all other players fold or leave the table, the system may activate the Mystery Jackpot for the remaining player. This feature gives an extra incentive for players to stay engaged, even in situations where they are the only one still actively playing.

Benefits to Players: Players are encouraged to stay in the game longer, knowing that being the last player at the table or continuing through multiple rounds may result in a jackpot activation. The “last man standing” concept adds an element of perseverance to the game, rewarding players who outlast their competition. This feature keeps the gaming experience engaging, even when player participation dwindles.

Benefits to Casinos: Casinos benefit from increased player retention, as players are incentivized to stay at the table longer, even when others leave. This criterion helps keep tables active and prevents early abandonment of games. By offering a jackpot activation for players who continue betting through several rounds or remain the last active participant, casinos may drive longer play sessions and maintain a more engaging environment.

### Example Walk-Through Scenario:

In a poker session, multiple players have been betting aggressively, but as the game progresses, all but one player, Jack, either fold or leave the table. The system recognizes that Jack is the last remaining active player, and automatically triggers the Mystery Jackpot for him. A notification appears on Jack's screen, informing him that the jackpot is live due to his persistence in staying at the table.

Jack, excited by the recognition of his solo participation, places a side bet on the jackpot for the next round. The opportunity to win the jackpot adds excitement to what would otherwise be a lonely session, motivating Jack to continue betting and stay engaged with the game.

### Example System Procedural Flow:

1. Player Activity Monitoring: The system tracks the activity of all players at the table, monitoring when players fold, leave, or stop betting.
2. Last Man Standing Detection: When only one player remains active or betting through several consecutive rounds, the system triggers the activation of the Mystery Jackpot for that player.
3. Jackpot Activation: The remaining player is notified that the jackpot is live, and they may place side bets during the following rounds to participate in the jackpot.
4. Player Participation: The system logs all side bets and contributions to the jackpot pool, ensuring that the last remaining player has a chance to win the jackpot.
5. Jackpot Payout and Reset: After the jackpot is won, the system disburses the payout and resets the tracking for future “last man standing” situations.

### Noteworthy Aspects and Features:

Persistence Reward: This criterion rewards players who continue betting even when others leave, encouraging perseverance and keeping the game engaging.
Increased Retention: Casinos benefit from longer play sessions, as players are motivated to stay active, knowing that remaining the last player at the table may trigger the jackpot.
Engagement During Quiet Periods: The activation of the jackpot in “last man standing” situations keeps players engaged, even when tables become quieter or less populated.

### Mystery Jackpot Enabling/Disabling Criteria #56—Activation For Achieving a Specific Wager-to-Win Ratio

Description and Implementation: This enabling criterion activates the Mystery Jackpot when a player achieves a specific wager-to-win ratio, meaning that their total winnings exceed their total bets by a certain multiplier. The system tracks each player's cumulative bets and winnings in real-time and triggers the jackpot when the player's win ratio meets the predefined threshold (e.g., winnings 3× or 5× the amount wagered). This criterion rewards players who manage to achieve large returns relative to their bets.

For example, in a blackjack game, the system may activate the Mystery Jackpot when a player's total winnings reach three times the amount they've wagered during the session. The jackpot is then available for the player to participate in, rewarding them for their profitable gameplay.

Benefits to Players: Players who achieve significant returns on their bets are rewarded with the chance to participate in the Mystery Jackpot, adding an extra incentive to continue playing. This feature recognizes and rewards successful play, encouraging players to strive for higher win ratios and maintain their winning streaks. The activation of the jackpot based on a favorable wager-to-win ratio keeps the gaming experience exciting and rewarding.

Benefits to Casinos: Casinos benefit from extended play sessions, as players are motivated to continue betting in hopes of achieving the wager-to-win ratio that triggers the jackpot. This feature encourages players to place more strategic bets, driving higher wager volumes. By rewarding players for achieving a specific win ratio, casinos may create a more dynamic gaming environment that fosters competitive play and player retention.

### Example Walk-Through Scenario:

Sarah is playing poker at an ETGT and has managed to achieve a strong win streak, with her total winnings now exceeding three times the amount she has wagered during her session. The system tracks her performance and, as soon as she reaches the predefined win ratio, the Mystery Jackpot is activated for her. A notification appears on Sarah's screen, congratulating her for reaching the threshold and informing her that the jackpot is live.

Excited by this recognition of her profitable gameplay, Sarah places a side bet on the jackpot for the next round.

The opportunity to participate in the jackpot motivates her to continue betting strategically, knowing that her success has led to this exclusive reward.

### Example System Procedural Flow:

1. Wager and Win Tracking: The system tracks each player's cumulative wagers and winnings in real-time, updating the player's win-to-wager ratio throughout the session.
2. Ratio Detection: When a player's winnings exceed their wagers by the predefined ratio (e.g., 3×), the system triggers the activation of the Mystery Jackpot for that player.
3. Jackpot Activation: The player is notified that the jackpot is now live, and they may place side bets during future rounds to participate in the jackpot.
4. Player Participation: The system logs all side bets and contributions to the jackpot pool, ensuring that the player's favorable win ratio is linked to their jackpot participation.
5. Jackpot Payout and Reset: After the jackpot is won, the system disburses the payout and resets the wager-to-win tracking for future sessions.

### Noteworthy Aspects and Features:

Profitable Play Reward: This criterion rewards players who achieve favorable win ratios, motivating them to continue playing and striving for higher returns.
Competitive Engagement: Players are encouraged to place strategic bets and aim for larger wins, increasing engagement and wager volumes.
Longer Play Sessions: Casinos benefit from players staying longer in pursuit of the win-to-wager ratio that may trigger the jackpot, leading to increased player retention and higher revenue.

### Electronic Gaming Machine (EGM) Devices and System(S)

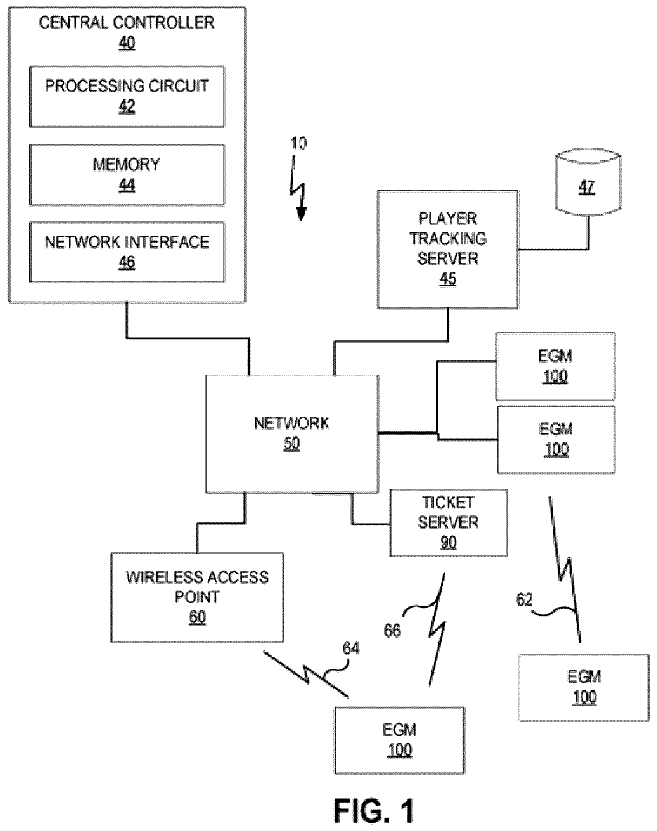

FIG. 1 illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

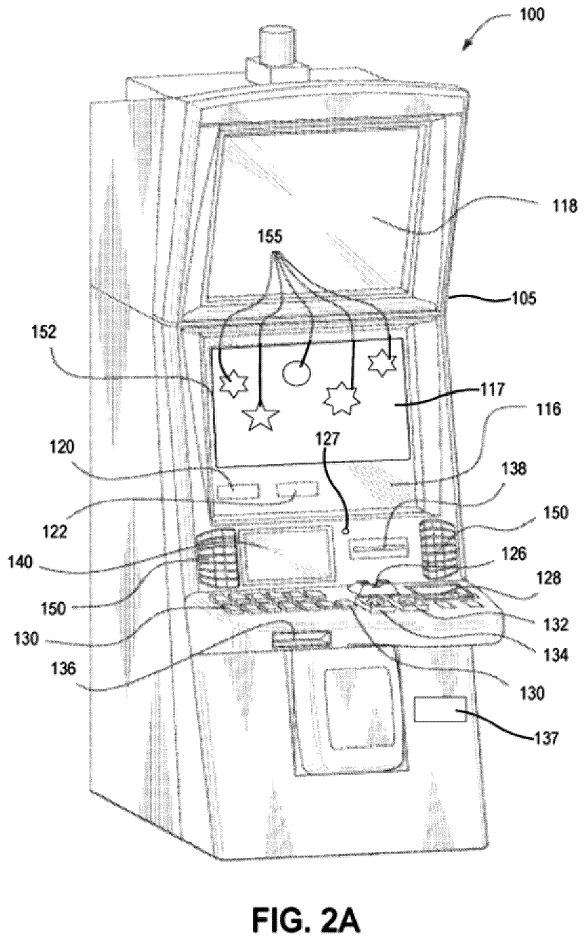

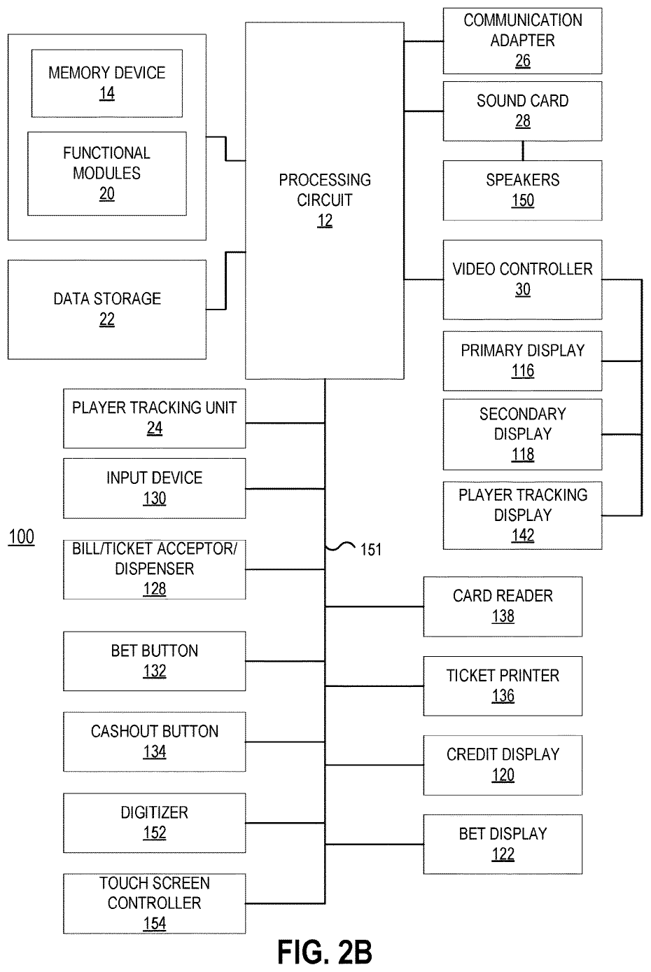

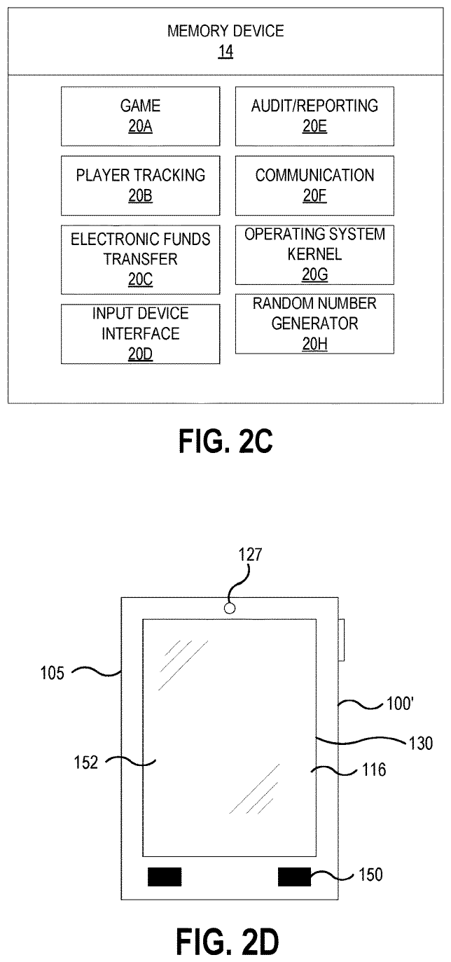

Embodiments herein may include different types of gaming devices. Various embodiments are illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that may be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the Innovative concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which may include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EE PROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and optionally controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

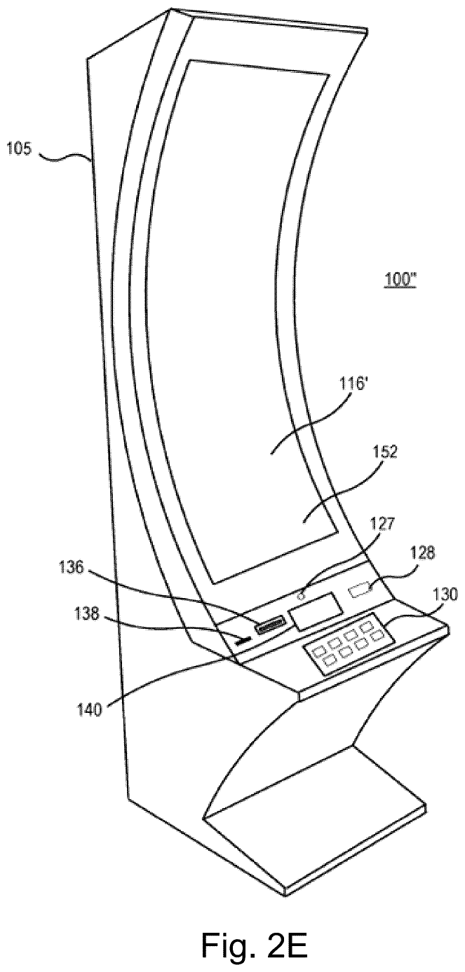

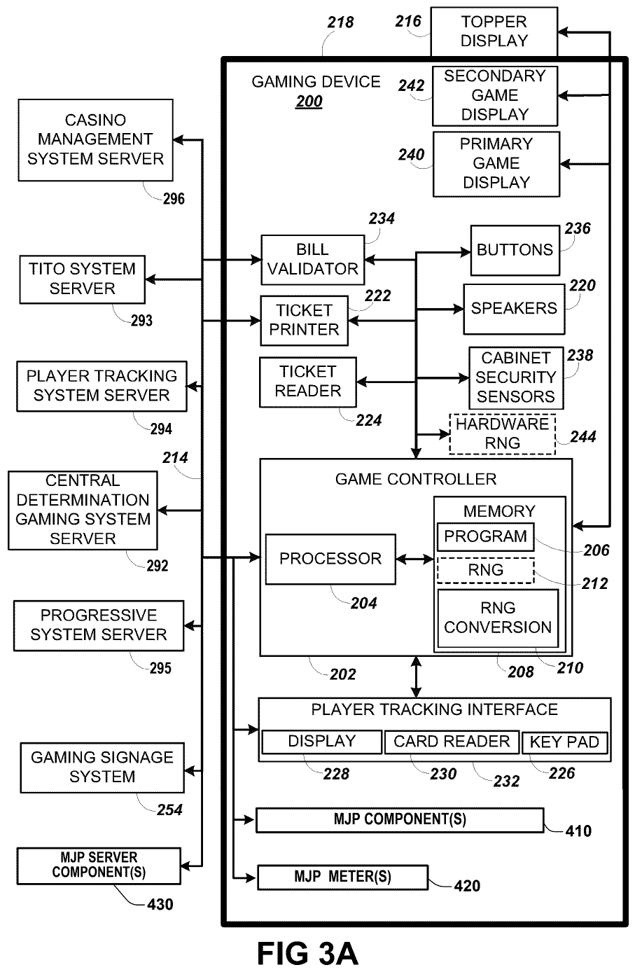

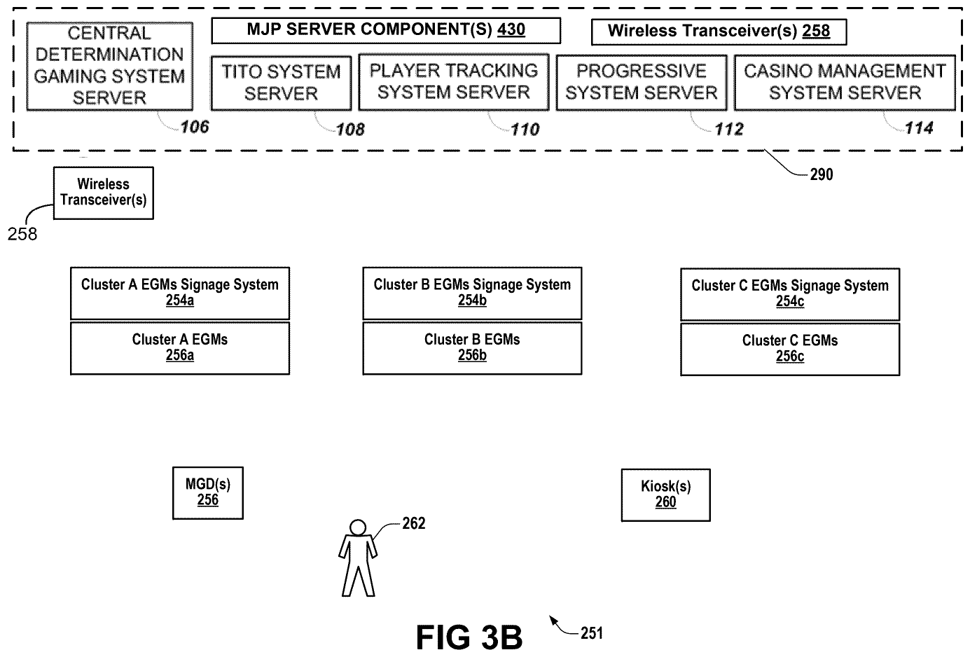

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits may be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

In some embodiments, in response to receiving a wager from a user of a gaming device, a gaming system displays, on a display device of the gaming device, a graphical interface for a wagering game. The graphical interface includes a plurality of game symbols arranged in an array (also referred to herein as a grid) of a plurality of lines (also referred to herein as rows) of game symbols. Based on the array, a game result for the wagering game is determined. A game award is provided to the user in response to the game result indicating a winning game result. In some examples, a winning game result occurs when the grid of game symbols includes a winning shape formed by a combination of game symbols.

In additional or alternative embodiments, subsequent play (or subsequent stages) of the wagering game includes generating a new array based on the array. For example, the winning combination of game symbols may be removed and replaced (e.g., the previously displayed symbols may cascade down to fill the removed slots in the array). These and other aspects will be described in greater detail below.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 3A is a block diagram depicting various functional elements of a gaming device 200 (e.g., an EGM) in an example embodiment. All or parts of gaming device 200 shown may be used to implement any one of the example gaming devices depicted in FIGS. 1 and 2A-E.

Communication between or among the gaming devices and/or the server computers 290, may be direct or indirect using one or more communication protocols. As an example, gaming devices 100 and the server computers 290 may communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks may allow gaming devices to communicate with one another and/or the server computers 290 using a variety of communication-based technologies, such as radio frequency (RF) (e.g., wireless fidelity (WiFi®) and Bluetooth®), cable TV, satellite links and the like.

In some implementation, server computers 290 may not be necessary and/or preferred. For example, in one or more implementations, a stand-alone gaming device may implement one or more aspects of the present disclosure. However, it is typical to find multiple EGMs connected to networks implemented with one or more of the different server computers 290 described herein.

The server computers 290 may include a central determination gaming system server 292, a ticket-in-ticket-out (TITO) system server 293, a player tracking system server 294, a progressive system server 295, and/or a casino management system server 296. Gaming devices may include features to enable operation of any or all servers for use by the player and/or operator (e.g., the casino, resort, gaming establishment, tavern, pub, etc.). For example, game outcomes may be generated on a central determination gaming system server 292 and then transmitted over the network to any of a group of remote terminals or remote gaming devices that utilize the game outcomes and display the results to the players.

As shown in FIG. 3A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 3A also depicts utilizing a ticket printer 222 to print tickets for a TITO system server 293. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 may be a central processing unit (CPU) that has one or more multi-specific processing units and memory mediums (e.g., cache memory) that function as buffers and/or temporary storage for data. Alternatively, processor 204 may be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 3A illustrates that game controller 202 includes a single processor 204, game controller 202 is not limited to this representation and instead may include multiple processors 204 (e.g., two or more processors).

FIG. 3A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 3A illustrates that game controller 202 includes a single memory 208, game controller 202 may include multiple memories 208 for storing program instructions and/or data.

Memory 208 may store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that may be translated into machine code in a format that may be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 may be set up to generate one or more game instances based on instructions and/or data that gaming device 200 exchanges with one or more remote gaming devices, such as a central determination gaming system server 292. For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 292 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences may require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 3A illustrates that gaming device 200 may include an RNG 212 that utilizes hardware and/or software to generate RNG outcomes that lack any pattern. The RNG operations are often specialized and non-generic in order to comply with regulatory and gaming requirements. For example, in a slot game, game program 206 may initiate multiple RNG calls to RNG 212 to generate RNG outcomes, where each RNG call and RNG outcome corresponds to an outcome for a reel. In another example, gaming device 200 may be a Class II gaming device where RNG 212 generates RNG outcomes for creating Bingo cards. In one or more implementations, RNG 212 may be one of a set of RNGs operating on gaming device 200. More generally, an output of the RNG 212 may be the basis on which game outcomes are determined by the game controller 202. Game developers may vary the degree of true randomness for each RNG (e.g., pseudorandom) and utilize specific RNGs depending on game requirements. The output of the RNG 212 may include a random number or pseudorandom number (either is generally referred to as a “random number”).

In FIG. 3A, RNG 212 and hardware RNG 244 are shown in dashed lines to illustrate that RNG 212, hardware RNG 244, or both may be included in gaming device 200. In one implementation, instead of including RNG 212, gaming device 200 may include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 may be a random number generator that securely produces random numbers for cryptography use. The gaming device 200 then uses the secure random numbers to generate game outcomes for one or more game features. In another implementation, the gaming device 200 may include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game may use one or more lookup tables (also called weighted tables) as part of a technical solution that satisfies regulatory requirements for randomness and RTP. In particular, a lookup table may integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table may involve engineering decisions with respect to how RNG outcomes are mapped to game outcomes for a given game feature, while still satisfying regulatory requirements for RTP. Configuring a lookup table may also involve engineering decisions about whether different game features are combined in a given entry of the lookup table or split between different entries (for the respective game features), while still satisfying regulatory requirements for RTP and allowing for varying levels of game volatility.

FIG. 3A illustrates that gaming device 200 includes an RNG conversion engine 210 that translates the RNG outcome from RNG 212 to a game outcome presented to a player. To meet a designated RTP, a game developer may set up the RNG conversion engine 210 to utilize one or more lookup tables to translate the RNG outcome to a symbol element, stop position on a reel strip layout, and/or randomly chosen aspect of a game feature. As an example, the lookup tables may regulate a prize payout amount for each RNG outcome and how often the gaming device 200 pays out the prize payout amounts. The RNG conversion engine 210 may utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 3A also depicts that gaming device 200 is connected over network 214 to player tracking system server 294. Player tracking system server 294 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she may insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player may add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that may be perceived by the player. These effects add to the excitement of a game, which makes a player more to enjoy the playing experience. Auditory effects include various sounds that are projected by the speakers 220. Visual effects include flashing lights, strobing lights or other patterns displayed from lights on the gaming device 200 or from lights behind the information panel.

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, at least some gaming devices may include or be coupled to one or more wireless transmitters, receivers, and/or transceivers that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between one or more gaming devices and a mobile device. After establishing a secure wireless connection between the gaming device and the mobile device, the wireless transmitter or transceiver does not send and/or receive application data to and/or from the mobile device. Rather, the mobile device communicates with gaming devices using another wireless connection (e.g., WiFi® or cellular network). In another implementation, a wireless transceiver establishes a secure connection to directly communicate with the mobile device. The mobile device and/or gaming device(s) send and receive data utilizing the wireless transceiver instead of utilizing an external network. For example, the mobile device would perform digital wallet transactions by directly communicating with the wireless transceiver. In one or more implementations, a wireless transmitter may broadcast data received by one or more mobile devices without establishing a pairing connection with the mobile devices.

The MJP Component(s) 410 represent specialized, proprietary hardware and software modules integrated within the Electronic Gaming Machine (EGM) specifically designed to facilitate the execution of Mystery Jackpot (MJP) features. Unlike standard gaming components that manage base game logic (such as slot reel outcomes), the MJP Component(s) 410 function as a dedicated local engine for processing “Mystery” events that occur independent of the base game's symbol combinations. These components are responsible for receiving and interpreting high-priority signals from the central server regarding jackpot triggering events, such as a “Dealer-Initiated” trigger or a “Sponsor-Funded” event. Functionally, the MJP Component(s) 410 manage the “Lockout” state protocols required during multi-game synchronization, ensuring that when a system-wide mystery jackpot is triggered, the EGM's current state is safely paused or overlaid with the jackpot presentation without corrupting the integrity of an active wager. In terms of implementation, the MJP Component(s) 410 interface directly with the EGM's peripheral controller to override standard display outputs with “Jackpot Mode” animations and synchronized lighting effects. They also act as the local enforcement point for eligibility rules; for instance, communicating with the Player Tracking Unit to verify if the specifically logged-in player meets the dynamic criteria (e.g., Tier Level or recent betting velocity) required to unlock a specific mystery pool. Crucially, these components facilitate the “Neighbor Luck Share” features by interfacing with proximity sensors to report the machine's active status to the specific network when a neighboring terminal triggers a win. By isolating the MJP logic into these specific components, the system ensures that the complex, variable-probability math of the mystery jackpot does not interfere with the regulated, static-probability math of the base game, creating a dual-layered gaming experience where players are simultaneously engaging with a local game and a networked, meta-game economy.

MJP Meter(s) 420 serve as the dedicated visual interface and tracking mechanism for the Mystery Jackpot system on the gaming device, distinct from the standard credit and bet meters. These meters are implemented as dynamic, programmable displays-often utilizing secondary LCD screens or high-resolution overlays on the primary display—that visualize the current value and growth rate of active mystery pools. Unlike traditional progressive meters that simply tick upward based on coin-in, MJP Meter(s) 420 are configured to display personalized and context-aware data. For example, they may show a “Personalized Odds” meter that visually fills up as a player's session duration increases, reflecting the “Jackpot Odds Adjustment Engine” calculations in real-time. Furthermore, these meters support the “Dynamic Acceleration” feature, capable of changing their visual behavior (e.g., color intensity, ticking speed, or animation style) to reflect the current “Heat Level” of the casino floor based on aggregate player concurrency.

Operationally, the MJP Meter(s) 420 receive data streams from the MJP Component(s) 410 rather than the main game controller, ensuring that the jackpot information is synchronized with the server-side state. They are capable of displaying multiple tiered pools simultaneously (e.g., “Mini,” “Major,” “Grand,” and “Sponsor Exclusive”), unlocking or graying out specific tiers based on the player's eligibility status. This selective visibility is a notable novelty, transforming the meter from a passive informational sign into an active engagement tool that provides immediate feedback on a player's status. The meters also facilitate the “Sponsor Integration” by rendering third-party branding or “Powered By” messages directly alongside the currency figures, physically linking the external funding source to the potential reward in the player's field of view.

The MJP Server Component(s) 430 represent the backend infrastructure and logic modules resident within the Casino Server System that orchestrate the complex, multi-terminal operations of the Mystery Jackpot network. These components function as the central brain for the MJP ecosystem, hosting important sub-systems such as the “Jackpot Odds Adjustment Engine (JOAE)” and the “Jackpot Lifecycle Manager (JLM).” Unlike standard progressive controllers that merely aggregate contributions, the MJP Server Component(s) 430 actively compute and distribute dynamic game states. They are responsible for ingesting real-time telemetry from the casino floor-such as dealer performance metrics, social media activity scores, and player proximity data- and using this inputs to modify the probability curves of the jackpot RNG in real-time.

Implementation-wise, the MJP Server Component(s) 430 manage the “Shadow Ledger” for third-party sponsored funds, ensuring that external capital injected by advertisers is correctly segregated from player funds until a win occurs. They also execute the “Multi-Game State Synchronization” algorithm, sending “Prepare to Lock” signals to hundreds of disparate terminals (slots, tables, mobile devices) to align them for a simultaneous jackpot event. These components act as a secure gateway, interfacing with the “Sandboxed Verification Module” to safely process external data triggers without exposing the specific gaming logic to the public internet. By centralizing the decision-making logic for “Neighbor Bonuses” and “Redistribution Rules,” the MJP Server Component(s) 430 allow the casino to deploy sophisticated, floor-wide gamification strategies that adapt dynamically to liquidity levels and player behavior, solving the technical challenge of managing a unified, high-frequency jackpot experience across a heterogeneous mix of gaming devices.

It will be appreciated that the present disclosure is not limited only to those implementations shown in the Figures. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices may also include other processors that are not separately shown. Using FIG. 3A as an example, gaming device 200 may include display controllers (not shown in FIG. 3A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 3B depicts a casino gaming environment in an example embodiment. In this example, the casino 251 includes banks (e.g., 252a, 252b, 252c) of EGMs. In this example, each bank 252 of EGMs includes a corresponding gaming signage system (e.g., 254a, 254b, 254c). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 290, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 292, one of the EGMs, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 293. For example, the TITO system server 293 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 294. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

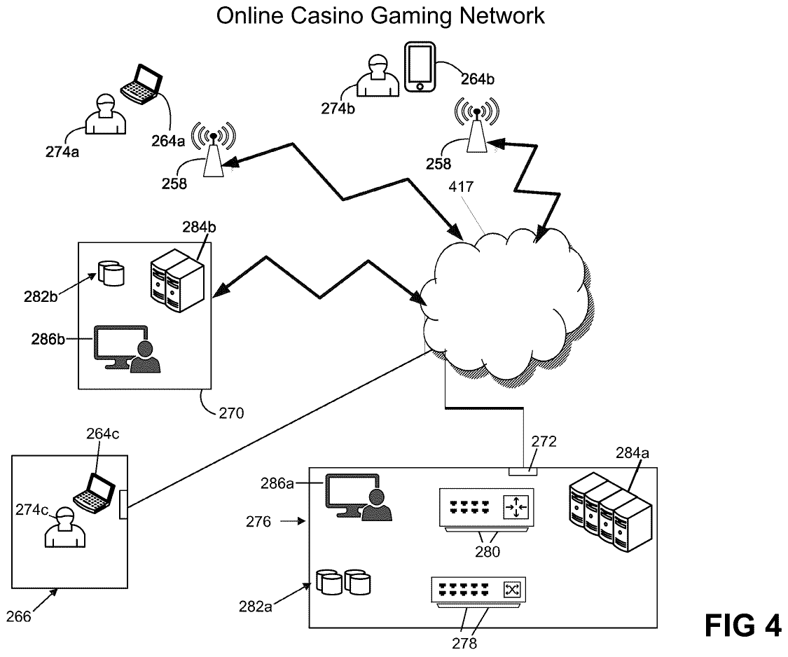

FIG. 4 is a diagram of components of a system for providing online gaming in an example embodiment. As with other Figures presented in this disclosure, the numbers, types and arrangements of gaming devices shown in FIG. 4 are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 4. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 4, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

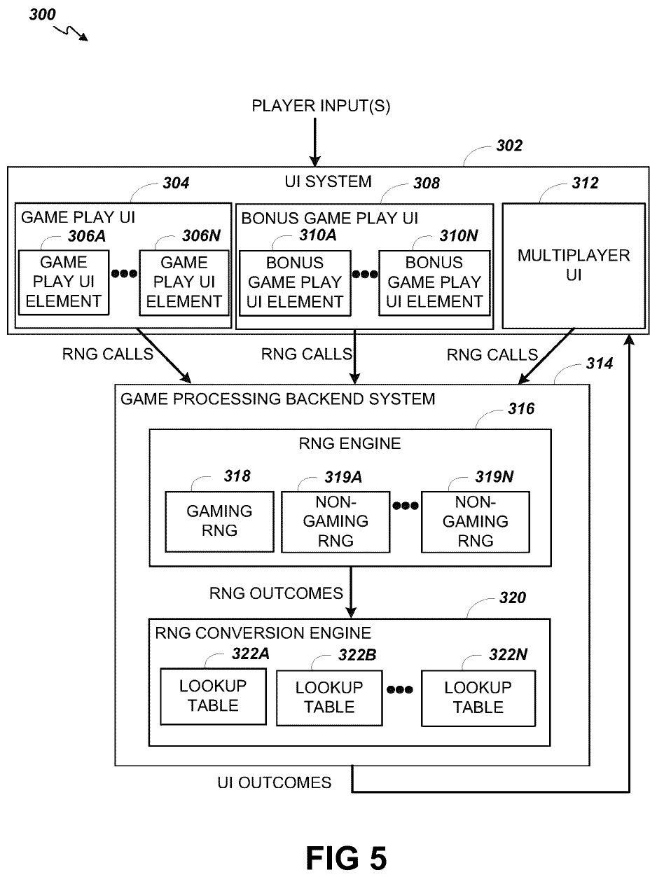

FIG. 5 illustrates, in block diagram form, an implementation of a game processing architecture 300 that implements a game processing pipeline for the play of a game in accordance with various implementations described herein. As shown in FIG. 5, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 may implement the game processing pipeline using a gaming device, such as gaming device 200 of FIG. 3A. Alternatively, portions of the gaming processing architecture 300 may implement the game processing pipeline using a gaming device and one or more remote gaming devices, such as central determination gaming system server 292 shown in FIG. 3B.

The UI system 302 includes one or more UIs that a player may interact with. The UI system 302 may include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 5 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 may transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N may differ from the bonus game play UI elements 310A-310N.

FIG. 5 also illustrates that UI system 302 may include a multiplayer UI 312 purposed for game play that differs or is separate from the typical base game. For example, multiplayer UI 312 may be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device may be collectively linked to determine a tournament outcome. To enhance a player's gaming experience, tournament mode may modify and synchronize sound, music, reel spin speed, and/or other operations of the gaming devices according to the tournament game play. After tournament game play ends, operators may switch back the gaming device from tournament mode to a primary game mode to present the base game. Although FIG. 5 does not explicitly depict that multiplayer UI 312 includes UI elements, multiplayer UI 312 may also include one or more multiplayer UI elements.

Based on the player inputs, the UI system 302 may generate RNG calls to a game processing backend system 314. As an example, the UI system 302 may use one or more application programming interfaces (APIs) to generate the RNG calls. To process the RNG calls, the RNG engine 316 may utilize gaming RNG 318 and/or non-gaming RNGs 319A-319N. Gaming RNG 318 may corresponds to RNG 212 or hardware RNG 244 shown in FIG. 3A. As previously discussed with reference to FIG. 3A, gaming RNG 318 often performs specialized and non-generic operations that comply with regulatory and/or game requirements. For example, because of regulation requirements, gaming RNG 318 may correspond to RNG 212 by being a cryptographic RNG or pseudorandom number generator (PRNG) (e.g., Fortuna PRNG) that securely produces random numbers for one or more game features. To securely generate random numbers, gaming RNG 318 may collect random data from various sources of entropy, such as from an operating system (OS) and/or a hardware RNG (e.g., hardware RNG 244 shown in FIG. 3A). Alternatively, non-gaming RNGs 319A-319N may not be cryptographically secure and/or be computationally less expensive. Non-gaming RNGs 319A-319N may, thus, be used to generate outcomes for non-gaming purposes. As an example, non-gaming RNGs 319A-319N may generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 3A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 may utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables may be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system may update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Further described herein are network-based systems and methods for seamlessly operating multi-vendor gaming devices and management systems within a casino.

Electronic gaming machines (EGMs), electronic gaming tables (EGTs), or other types of gaming devices provide a variety of wagering games such as slot games, video poker games, video blackjack games, roulette games, video bingo games, keno games and other types of games that are frequently offered at casinos and other locations. EGMs and EGTs are made by a variety of different manufactures, including but not limited to Aristocrat (ATI), Light and Wonder (LNW), International Game Technology (IGT), Konami Gaming, etc. Many EGMs/EGTs communicate with slot machine interface boards (SMIBs) via the slot accounting system (SAS) or the game to system (G2S) protocol. Further, there are a number of different casino monitoring/management systems (CMS) that are provided by the different EGM/EGT manufactures. The result of the incompatible frontend and backend is that when a casino buys EGMs/EGTs from vendor A, and installs the CMS system from vendor A to manage and control the casino's various EGMs/EGTs, then the casino may be locked into vendor A's solution, as interoperability between the gaming machines, their SMIBs, and management solutions from different vendors is generally non-existent. This limits the options that casinos have regarding management system solutions that deviate from the already installed base of vendor A's management solution.

Gaming devices (e.g., EGMs, EGTs, bar tops, gaming servers, mobile devices, mobile game devices, etc.), may be a device located in a physical casino and/or at remote locations for online gaming. Gaming devices are made by a variety of different vendors, with the different vendors typically providing a closed management system for monitoring and controlling that vendor's gaming device. A SMIB is used within an EGM/Ts to allow the EGM/Ts to connect to a system server. However, SMIBs made by different vendors are proprietary, and may use different controllers, power supplies, connectors, hardware, board sizes, and proprietary communication protocols. Each vendor's SMIB is designed to connect its proprietary management system to its EGM/Ts and to all other manufacturers' EGM/Ts. For instance, there is a SMIB from supplier A designed to connect to supplier A's machines, and to supplier B's, C's, and D's machines, a SMIB from supplier B designed to connect to supplier B's machines as well as to supplier A's, C's, and D's machines, etc. Once a casino decides to network its casino floor, it is locked into one vendor's hardware and software solutions.

For example, a casino may initially select an implementation from supplier A, with supplier A's SMIBs installed in the EGM/Ts that communicate with supplier A's CMS. As used herein, a CMS refers to any backend system or software service designed to operate with a casino's gaming device network such as a casino accounting system, a ticket voucher system, a player account system, a social network system, a responsible gaming system, a marketing system, a bonus system, a progressive system, a concierge system, and/or a Remote Gaming System (RGS). Generally, RGS is a solution for vendors and operators that enables implementation and distribution of online, mobile, and server-based gaming content.

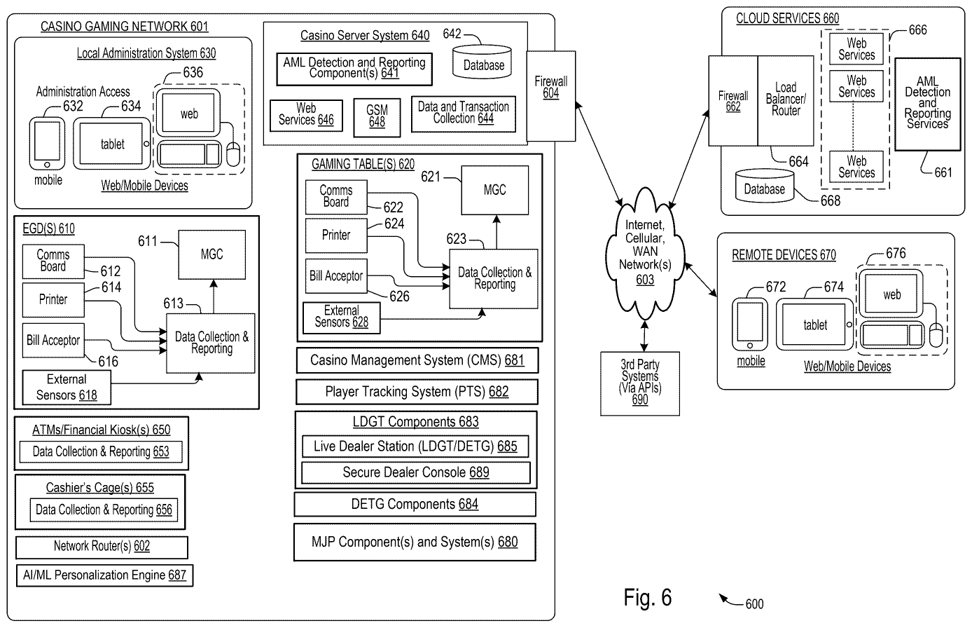

FIG. 6 illustrates a simplified block diagram of a specific example embodiment of a Gaming Network 600 which may be configured or designed to implement various automated money laundering detection and reporting techniques described and/or referenced herein. As described in greater detail herein, different embodiments of gaming networks may be configured, designed, and/or operable to provide various different types of operations, functionalities, and/or features generally relating to automated money laundering detection and reporting techniques. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 600 may include a plurality of different types of components, devices, modules, processes, systems, etc., which, for example, may be implemented and/or instantiated via the use of hardware and/or combinations of hardware and software. For example, as illustrated in the example embodiment of FIG. 6, the Gaming Network may include one or more of the following types of systems, components, devices, processes, etc. (or combinations thereof):
Casino Gaming Network(s) 601. In at least one embodiment, the Casino Gaming Network 601 may include or may correspond to one or more gaming network(s), systems, components, devices, etc., which are associated with one or more casino gaming establishments such as, for example, Harrah's Casino (Las Vegas), Caesars Palace (Las Vegas), The Palazzo (Las Vegas), etc. In at least one embodiment, a Casino Gaming Network may be associated with a real-world, physical casino which is located at a particular geographic location. In some embodiments, the Casino Gaming Network may include multiple gaming networks associated with multiple casino gaming establishments at different physical locations (such as, for example, Harrah's Casino Las Vegas, Harrah's Casino New Orleans, Harrah's Casino Atlantic City, etc.).
Internet, Cellular, and WAN Network(s) 603.
3rd Party Systems 690. In at least one embodiment, one or more 3rd Party Systems may include remote server system(s)/service(s), which, for example, may be configured or designed to provide various types of services described and/or referenced herein. In at least one embodiment, one or more 3rd Party Systems may communicate with other components, devices, systems of the Gaming Network via APIs and/or other types of standardized (and/or proprietary) communication protocols. Examples of various types of 3^{rd} Party Systems may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Automated money laundering detection and reporting services,
   Remote Database System(s) which, for example, may be operable to store and provide access to various types of information and data described herein.
Remote Device(s) 670—In at least one embodiment, the Remote Device(s) may be operable to provide administration and customer remote access to other components, devices, systems of the Gaming Network. According to different embodiments, one or more Remote Device may be configured or designed to perform and/or implement various types of functions, operations, actions, and/or other features such as those described or referenced herein (e.g., such as those illustrated and/or described with respect to FIG. 6).
Cloud Services 660—In at least one embodiment, Cloud Services may include a plurality of different public and/or provide computing clouds which, for example, may reside at different physical and/or geographic locations, and which may each be configured or designed to provide different types of services. For example, as illustrated in the example embodiment of FIG. 6, Cloud Services 660 may include functionality for performing and/or implementing ML Analysis, Detection and Reporting Services such as one or more of those described herein.

According to specific embodiments, the at least some of the computing clouds may include several different types of local area networks such as, for example, a backbone LAN which may be utilized for providing localized communication between various local network elements within a given computing cloud, and an internet LAN which, for example, may be utilized for providing WAN or Internet access to various local network elements within the computing cloud. In at least one embodiment, one or more of the computing clouds may be operable to host a variety of different types of applications and/or other software for performing various types of services such as, for example, one or more of those described herein. Additionally, in at least one embodiment, one or more of the computing clouds may be operable to provide various types of database services such as, for example, data storage, database queries, data access, etc. As illustrated in the example embodiment of FIG. 6, cloud services network 660 may include one or more of the following components, devices, and/or systems (or combinations thereof): firewall components 662, load balancer and router components 664, Web services components 666, database components 668, AML detection and reporting components 661.

As illustrated in the example embodiment of FIG. 6, the Casino Gaming Network 601 may include a plurality of different types of components, devices, modules, processes, systems, etc., which, for example, may be implemented and/or instantiated via the use of hardware and/or combinations of hardware and software. In at least one embodiment, the Casino Gaming Network 601 may include various types of systems, components, devices, processes, etc., such as one or more of those described below.
Casino Server System(s) (640)
Local Administration System(s) (630)
Electronic Gaming Device(s) (EGDs) (610)
Wager-based Gaming Table(s) (620)
ATMs/Financial Kiosk(s) (650)
Cashier's Cage(s) (655)
Network Router(s) (602)
Casino Management System (CMS) (681)
Player Tracking System (PTS) (682)
LDGT Components (683)
DETG Components (684)
Live Dealer Station (LDGT/DETG) 685
Secure Dealer Console 689
AI/ML Personalization Engine 687
MJP Component(s) (680)
AML Detection and Reporting Component(s) (641)
Casino Server System(s) 640

The Casino Server System(s) 640 represents the centralized command and data processing specific of the Casino Gaming Network 601. Its primary purpose is to host, manage, and execute the high-level logic, data storage, and communication services required to operate the entire gaming environment. This system is comprised of several important sub-components, including a central Database 642 that stores all persistent data, such as historical game information, player account details, gaming device configurations, and a comprehensive log of all financial transactions. A notable module is the Data and Transaction Collection component 644, which is specifically designed to aggregate financial transaction events from all connected endpoints, including EGDs 610, Gaming Table(s) 620, ATMs 650, and Cashier's Cage(s) 655. The system also integrates Web Services 646 for managing web-based communications and data aggregation, Cellular (GSM) components 648 for transporting gaming data to external systems like Cloud Services 660, and a Firewall 604 for network security. A novel and important function of this server is hosting the AML Detection and Reporting Component(s) 641, which leverages the centrally collected transaction data to perform sophisticated, automated analysis. This centralized architecture provides a significant technical improvement over traditional, siloed systems by creating a single, unified data repository, enabling holistic, real-time analysis of all casino activities, which is desirable for both operational intelligence and advanced regulatory compliance functions like automated AML monitoring.

The Local Administration System(s) 630 provides on-premises administrative access and control over the Casino Gaming Network 601. This system is composed of various user-facing devices, such as mobile devices 632, tablets 634, and web-based computer systems 636, enabling casino administrators and managers to perform their duties from anywhere within the establishment. Its specific function is to provide the necessary interfaces for configuring, registering, monitoring, and analyzing the performance and status of network components, such as EGDs and servers. A particularly important feature of this system is its ability to provide local administrative access for configuring and monitoring Anti-Money Laundering (AML) and suspicious activity alerts. This allows managers to receive real-time notifications, generate reports, and analyze potential ML activities as they are detected by the central AIL Detection and Reporting Component(s) 641. This direct, local administrative layer represents a significant operational improvement, enhancing security and responsiveness by empowering staff to act on important alerts immediately, rather than waiting for reports from a remote or back-office-only system. The integration of mobile and web-based access points ensures that administrative control is both flexible and powerful, directly supporting the network's advanced monitoring and reporting capabilities.

The Electronic Gaming Device(s) (EGDs) 610 are the primary player-facing terminals within the casino, including devices like electronic slot machines, video poker machines, electronic gaming machines (EGMs), electronic table game terminals (ETGTs), etc. Each EGD is a complex system in itself, typically including a Master Gaming Controller (MGC) 611 that executes the game logic, a Comms Board 612 for network communication, a Printer 614 for issuing TITO vouchers, a Bill Acceptor 616 for receiving currency, and External Sensors 618 for security and interaction. A novel and important component of the EGD in this network is the Data Collection & Reporting module 613. While traditional EGDs report basic metering, this module is specifically configured to capture and report a granular stream of game-related information, wager data, and, most importantly, all financial transaction events (e.g., bill insertion, voucher cashout) in real-time. This data is passed via the MGC 611 and network to the Casino Server System 640. This enhanced data collection provides a foundational technical improvement, transforming the EGD from a simple gaming endpoint into a rich data source for the central AIL Detection and Reporting Component(s) 641, enabling the system to correlate specific financial transactions with game play patterns on a per-device basis.

The Wager-based Gaming Table(s) 620 represents the hardware and software systems used to monitor and manage live, wager-based table games such as baccarat, blackjack, or roulette. These may be traditional tables augmented with technology or fully electronic tables. Similar to EGDs, these tables are equipped with their own Master Gaming Controller (MGC) 621, Comms Board 622, Printer 624, Bill/voucher/coin acceptor 626, and External Sensors 628 (which may include chip readers or other tracking devices). The notable component within this system is the Data Collection & Reporting module 623. This module's function is to capture all game-related information, player tracking data, and wager information, including all financial transaction events that occur at the table, such as cash buy-ins or voucher redemptions. This data is then reported to the central Casino Server System 640. The integration of this component provides an important technical advancement by bringing live table games-which are often a blind spot for automated systems-into the same unified data collection network as electronic games. This allows the central AML Detection and Reporting Component(s) 641 to monitor and analyze financial activities from the gaming tables with the same level of scrutiny as EGDs, providing a complete, casino-wide view of all wagering and financial movements.

The ATMs/Financial Kiosk(s) 650 component represents non-gaming financial transaction points located within the casino environment. The primary function of these devices is to provide patrons with financial services, such as cash withdrawals, credit/debit card advances, and potentially TITO (Ticket-In, Ticket-Out) voucher redemption. A notable element of this component, and a significant technical improvement for the network, is its integrated Data Collection & Reporting 653 module. Unlike standard ATMs that report only to a banking network, this module is specifically configured to capture and report all financial transaction events (e.g., cash withdrawal amounts, times, frequencies) directly to the Casino Server System 640's Data and Transaction Collection 644 component. This integration is novel because it brings third-party financial hardware into the unified casino monitoring ecosystem. This allows the AML Detection and Reporting Component(s) 641 to correlate kiosk activity with a patron's gaming and on-property behavior, identifying patterns such as a player frequently withdrawing cash at a kiosk and immediately buying in at a table, which is an important piece of information for suspicious activity analysis.

The Cashier's Cage(s) 655 component represents the central banking and financial hub of the casino, managed by casino personnel. This is the location where patrons conduct high-value transactions, including cashing large TITO vouchers, redeeming chips, processing credit lines (markers), exchanging foreign currency, and performing large cash buy-ins. The most important piece of this component is the Data Collection & Reporting 656 system, which is integrated into the cashier's terminal. This system is designed to electronically capture and report all financial transaction events—particularly those involving large sums of cash or complex financial instruments—to the Casino Server System 640 in real-time. This represents a technical advancement over traditional, manual, or end-of-day paper-based reporting. By feeding this data directly into the Data and Transaction Collection 644 module, the AML Detection and Reporting Component(s) 641 gains complete visibility into the largest and most important financial movements within the casino. This enables the automated system to immediately flag and analyze transactions that meet or exceed regulatory reporting thresholds, significantly enhancing the casino's compliance capabilities.

The Network Router(s) 602 component represents the specific networking hardware responsible for directing and managing data traffic within the private Casino Gaming Network 601. This component is a fundamental enabler of the entire system, providing the desirable connectivity between all other components. It physically and logically links the distributed endpoints-such as the EGDs 610, Gaming Table(s) 620, and Local Administration System 630—to the centralized Casino Server System 640. Its function is to reliably and securely route data packets, ensuring the timely and uninterrupted flow of information. This is particularly important for the system's novel features, as it must handle the constant stream of real-time data from the Data Collection & Reporting (613, 623) modules at every gaming position, delivering it to the Data and Transaction Collection 644 module for immediate analysis. The router's performance, security (e.g., managing VLANs, access control lists), and reliability are foundational to the integrity and real-time nature of the network's AML detection and operational monitoring capabilities.

The Casino Management System (CMS) 681 is a high-level component that represents the comprehensive, overarching software and hardware platform for managing the entire casino floor. Its specific purpose is to provide a centralized suite of tools for casino operators to monitor, manage, and optimize all gaming-related operations. This includes functions like slot accounting (tracking money in/out), machine performance analysis, security monitoring, and regulatory compliance reporting. The CMS integrates with and utilizes data from nearly all other systems, including the EGDs 610, Gaming Table(s) 620, and especially the Player Tracking System (PTS) 682. Within this network, the CMS 681 is a primary consumer of the data aggregated by the Casino Server System 640. It leverages this unified data stream to provide operators with a holistic view of the casino's performance. This system is desirable for translating the raw data collected by the network into actionable business intelligence, enabling informed decisions on game placement, marketing promotions, and operational efficiency, all while ensuring compliance with gaming regulations.

The Player Tracking System (PTS) 682 is a specialized sub-system within the network, dedicated to managing player loyalty and marketing programs. Its primary function is to identify, track, and reward player activity across the casino. It operates by issuing player loyalty cards (or using mobile device identifiers) that patrons use at EGDs 610 and Gaming Table(s) 620. The PTS server then collects detailed data on that player's specific activity, such as games played, wager amounts, and duration of play. Based on this activity, the system awards loyalty points, complimentary items (“comps”), and other promotions to incentivize return visits. In the context of the Gaming Network 600, the PTS provides an indispensable layer of data: patron identity. By integrating PTS data with the financial event data from the Data and Transaction Collection 644 module, the AIL Detection and Reporting Component(s) 641 may move from anonymous device-based analysis to sophisticated, player-centric analysis. This allows the system to track a single patron's financial activities across multiple devices, tables, and kiosks, which is a technical prerequisite for detecting advanced suspicious patterns like structuring or chip passing.

The LDGT Components 683 include components, devices, and specialized hardware and software modules specifically configured or designed to operate “Live Dealer Gaming Table” (LDGT) systems. An LDGT system typically involves a live dealer conducting a game (e.g., baccarat, roulette) in a studio or on the casino floor, with the game being video-streamed to numerous players at remote electronic betting terminals. These components would therefore include high-definition cameras, audio equipment, video encoding and streaming servers, and the networking infrastructure to broadcast the live feed with minimal latency. It would also include the specific game server logic to manage the game state (e.g., “no more bets”), read game outcomes (e.g., from an RFID-enabled shoe or wheel), and communicate these outcomes to the connected player terminals to resolve wagers. Within the Gaming Network 600, these components would function as a specialized type of Gaming Table 620, integrating with the Data Collection & Reporting 623 module to ensure that all wagers and financial transactions from the associated remote terminals are captured and forwarded to the Casino Server System 640 for processing and AML analysis.

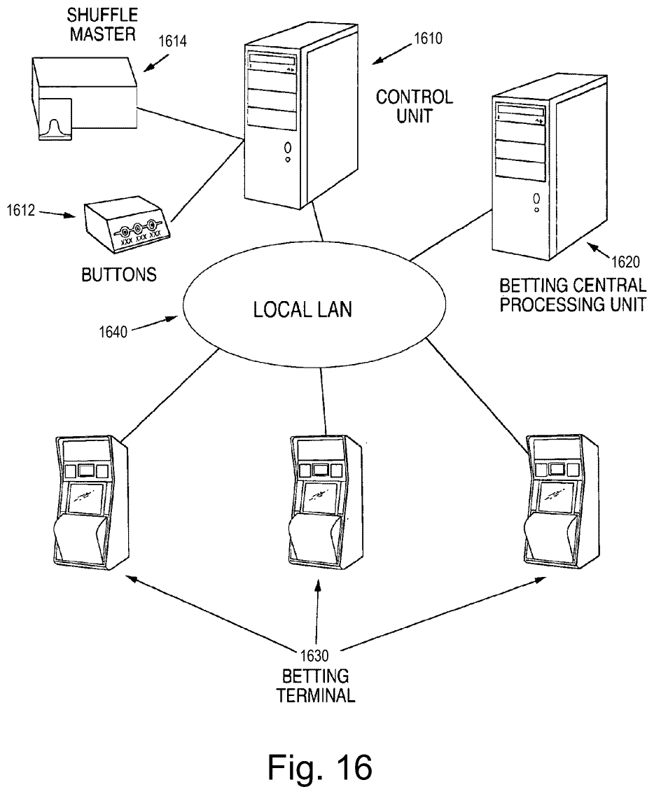

The DETG Components 684 include components, devices, and specialized hardware and software modules specifically configured or designed to implement one or more “Dealer-controlled Electronic Table Game” (DETG) systems. As detailed in the disclosure (e.g., FIG. 16, 17, 18), a DETG system comprises a live dealer at a central Dealing Table (1810) who performs the physical actions of the game (e.g., dealing cards from a shuffle master). These actions are processed by a Control Unit (CU) (1610) and a Betting Central Processing Unit (BCPU) (1620). The BCPU then determines the game outcome and communicates it over a Local LAN (1640) to multiple, individual Betting Terminals (BTs) (1630) where players have placed their wagers. Therefore, DETG Components 684 encompasses this entire architecture: the dealer's Dealing Table (1810) with its controls, the central BCPU (1620) for game logic and wager resolution, and the network of player-facing Betting Terminals (1630). This system functions as a highly scalable version of a Wager-based Gaming Table 620, and its BCPU would be responsible for reporting all aggregated financial transaction and wagering data from its terminals to the Casino Server System 640.

The Live Dealer Station (LDGT/DETG) 685 functions as the specialized physical and digital nexus for conducting hybrid table games within the Casino Gaming Network. Structurally, this component integrates traditional casino table equipment, such as card shoes and shufflers, with advanced digital capture and transmission hardware, including high-definition cameras, audio arrays, and real-time encoding servers. Its primary function is to facilitate the operation of Live Dealer Gaming Table (LDGT) and Dealer-controlled Electronic Table Game (DETG) systems by capturing the physical state of a game-such as the dealing of cards or the spin of a wheel—and converting these physical events into digital data streams and video feeds that are broadcast to remote betting terminals or mobile devices. This station operates by utilizing sensors, such as RFID readers in a smart shoe or optical recognition systems, to instantaneously identify game outcomes (e.g., Player, Banker, Tie) and transmit this data to the central game controller for wager resolution. A significant technical feature of the Live Dealer Station 685 is its integration with the network's unified Data Collection & Reporting architecture. Unlike standalone tables, this station is configured to capture and report granular financial transaction events and game state changes directly to the central Casino Server System in real-time. This connectivity addresses the technical problem of latency and data fragmentation in hybrid gaming, ensuring that remote players experience synchronized gameplay while simultaneously enabling the central system to perform automated Anti-Money Laundering (AML) analysis on table game transactions. The station provides a distinct advantage by extending the casino floor to remote locations while maintaining the integrity and auditability of physical gaming, effectively creating a bridge between the tactile authenticity of live dealers and the scalability of digital wagering platforms. By reporting all wager resolution data and dealer actions to the central system, the Live Dealer Station 685 enables the same level of rigorous automated monitoring for live games that is typically reserved for purely electronic gaming machines, thereby enhancing both operational efficiency and regulatory compliance.

The Secure Dealer Console 689 serves as the dedicated human-machine interface (HMI) utilized by live dealers to manage game states, verify outcomes, and interact with the underlying logic of the LDGT or DETG systems. Physically, this console is typically implemented as a ruggedized touchscreen terminal or a specialized keypad located at the dealer's position, specifically designed to withstand the casino environment while providing secure access to important game functions. Its specific function is to empower the dealer to input definitive game states-such as signaling No More Bets, confirming the start of a new hand, or verifying a card read error-thereby acting as a validation layer between the physical game actions and the digital game logic. The console operates by interfacing directly with the station's Master Gaming Controller and the central network, requiring secure authentication (such as biometric login or RFID badge scanning) to ensure that only authorized personnel may influence the game flow. A notable aspect of its novelty lies in its role as a security and integrity checkpoint within the automated ecosystem; it allows the dealer to override or confirm automated sensor readings (e.g., if an optical scanner misreads a card) while simultaneously logging all such manual interventions for audit purposes. This technical implementation solves the problem of discrepancies between analog game events and digital reporting by forcing a human-verified synchronization point before wagers are settled. Furthermore, the Secure Dealer Console 689 integrates with the automated money laundering detection systems by associating specific dealers with specific tables and timeframes, allowing the back-end analysis engines to correlate suspicious play patterns or financial irregularities with specific staff members. This capability provides a significant advantage in internal game protection, deterring collusion and ensuring that the hybrid gaming environment maintains the highest standards of fairness and security. The console ultimately ensures that while the game speed and settlement are automated, the important control of the game pace and integrity remains under strict, authenticated human supervision.

The AI/ML Personalization Engine 687 represents a sophisticated computational framework connected to the Casino Gaming Network, designed to dynamically tailor the gaming environment and user experience to individual patron preferences through the application of artificial intelligence and machine learning algorithms. Functionally, this engine acts as an intelligent analytics layer that consumes vast datasets aggregated by the Casino Server System, including player tracking records, historical wager patterns, game preference logs, and real-time session activity. Unlike traditional static rules engines that segment players based on simple tier status, the AI/ML Personalization Engine 687 utilizes predictive modeling to generate real-time, individualized recommendations and system adaptations. For instance, it may analyze a player's historical sensitivity to game volatility and current session duration to dynamically adjust the selection of games displayed on an EGM's menu or to proffer a customized promotional bonus calculated to maximize engagement at that specific moment. Technical implementation involves deep neural networks or regression models that continuously learn from player interactions, allowing the system to refine its predictions and offers over time. This component addresses the technical problem of information overload and generic user interfaces in modem casinos by filtering relevant content and creating a frictionless, bespoke experience for each user. A unique aspect of this engine is its ability to interact with the Context Interpreter to incorporate situational variables—such as location, time of day, and crowd density—into its personalization logic, thereby delivering hyper-relevant content that extends beyond simple gaming recommendations to include dining or entertainment suggestions. The integration of this engine provides a substantial advantage by transforming raw data into actionable intelligence that drives player retention and revenue, it shifts the casino's interaction model from reactive to proactive, anticipating player needs and desires before they are explicitly expressed. Furthermore, by automating the personalization process, the engine allows casino operators to scale high-touch customer service to the mass market, ensuring that every player receives a curated experience typically reserved for VIP patrons.

The MJP Component(s) and System(s) 680 serve as a comprehensive, high-level placeholder representing the collection of novel and proprietary hardware and software modules that collectively deliver the specific innovative features of the Mystery Jackpot (MJP) platform. Unlike standard, off-the-shelf gaming systems, this component is not a single monolithic unit but rather a distinct aggregation of unique functional modules that differentiate this specific gaming network from conventional architectures. Functionally, the MJP Component(s) 680 act as the primary enabling layer for the invention, providing the necessary computational logic, communication protocols, and interface operational capabilities to execute the specialized MJP techniques and features disclosed throughout the system. These features encompass a wide range of advanced functionalities, including the execution of new game mechanics, the integration of dynamic loyalty features, and the processing of real-time analytical data to drive game behavior. As a system-wide designation, the MJP Component(s) 680 manifest in and communicate with various disparate parts of the network infrastructure, this includes instantiations such as the MJP Component(s) 410 and MJP Meter(s) 420 located locally within Electronic Gaming Devices (EGDs), as well as the MJP Server Component(s) 430 running on the central server infrastructure. Through this distributed architecture, the MJP Component(s) 680 integrate deeply with standard casino operations systems, such as the Casino Management System (CMS) 681 and the Player Tracking System (PTS) 682. This deep integration allows the MJP Component(s) 680 to leverage existing data streams-such as player identity, tier status, and wagering history—to provide unique functionality that enhances player engagement. By bridging the gap between standard casino management tools and novel jackpot logic, the MJP Component(s) 680 provide the operational backbone for transforming a static gaming floor into a dynamic environment capable of supporting complex, multi-layered reward structures and interactive gaming experiences that are synchronized across the entire network.

Illustrative Use Case: Consider a casino operator utilizing the MJP Component(s) 680 to deploy a property-wide “Anniversary Mystery Event.” The operator configures the MJP Component(s) 680 to initiate a month-long celebration where jackpots are triggered not just by slot combinations, but by a combination of time-based windows and player loyalty tiers. As the event begins, the server-side elements of the MJP Component(s) 680 communicate with the Player Tracking System 682 to identify all currently active “Gold Tier” players. Simultaneously, the local elements of the MJP Component(s) 680 resident within the Electronic Gaming Devices (EGDs) on the floor receive a command to unlock a special “Anniversary Meter” on the displays of those specific players. When a “Gold Tier” player hits a specific wagering threshold, the MJP Component(s) 680 execute a unique probability algorithm that dynamically adjusts the odds of triggering the mystery prize based on the player's session duration. If the jackpot is triggered, the MJP Component(s) 680 coordinate a synchronized celebration across the network, overriding the local game displays to show the win while simultaneously updating the central accounting records via the Casino Management System 681. This demonstrates how the MJP Component(s) 680 function as the cohesive operational fabric that weaves together disparate system data to deliver a unified, highly targeted, and engaging player experience that would be impossible with disjointed, off-the-shelf components.

According to different embodiments, the Casino Server System(s) may include various systems, components, and/or devices for facilitating, initiating, and/or performing various operation(s), action(s), feature(s), and/or other functionality, such as, for example, one or more of the following (or combinations thereof):
Database components 642, which, for example, may be configured or designed to include functionality for storing and/or providing access to various types of information, events, and/or conditions such as, for example, one or more of the following (or combinations thereof): historical game-related information, ML information, ML rules, player ID information, gaming device ID information, location maps of gaming devices, casino-related information, historical financial transaction information, and/or other types of information described and/or referenced herein.
Web Services components 646, which, for example, may be configured or designed to include functionality for facilitating, aggregating gaming data, enabling, initiating, and/or performing various types of web-based services and communications.
Cellular (GSM/CDMA) Communication components 648, which, for example, may be configured or designed to include functionality for facilitating, enabling, initiating, and/or performing various types of cellular-based and/or wireless communications such as transporting gaming data to/from the Cloud Services 660.
Data And Transaction Collection components 644, which, for example, may be configured or designed to include functionality for facilitating, enabling, initiating, and/or performing collection of data and transactions (e.g., financial transaction events) occurring at various components and/or devices of the casino gaming network such as, for example, one or more of the following (or combinations thereof): EGD(s), gaming table(s), ATMs, financial kiosks, casino token storage tray(s), cashier cage component(s), wireless gaming devices, end user mobile device(s), remote devices (e.g., 670), etc.
Firewall component(s) 604.
AML Detection and Reporting Component(s) 641 is a specialized, software-based system hosted within the Casino Server System 640. Its specific purpose is to automate the process of detecting, analyzing, and reporting suspicious financial activities consistent with money laundering (ML). This component's functionality is a significant technical improvement over traditional, manual reporting. It operates by directly consuming the unified, real-time data stream from the Data and Transaction Collection 644 module, which aggregates financial events from all casino endpoints: EGDs 610, Gaming Table(s) 620, ATMs 650, and the Cashier's Cage(s) 655. The component then applies sophisticated rules and analytical models to this holistic dataset to identify suspicious patterns (e.g., structuring transactions to avoid thresholds, minimal-play wagering, chip passing). By integrating with the Player Tracking System 682, it may link activities across different devices to a single patron. This component is also designed to interface with e-Filing and Report Component(s) (1254), enabling the automated generation and electronic filing of suspicious activity reports (SARs) to the appropriate governmental agencies, thereby enhancing compliance, reducing manual overhead, and improving the speed and accuracy of regulatory reporting.

According to different embodiments, Electronic Game Device(s) (EGDs) may include one or more of the following (or combinations thereof): mechanical slot machines, electronic slot machines, electronic gaming machines (EGMs), electronic table game terminals (ETGTs), mobile gaming devices, video gaming machines, server-based gaming machines, and/or other types of devices or components which provide capabilities for enabling casino patrons to participate in gaming and/or wagering activities. In some embodiments, at least some mobile gaming devices may be implemented using personal mobile computing devices such as tablets, smartphones, laptops, PC's, and the like. As illustrated in the example embodiment of FIG. 6, one or more EGDs may be configured or designed to include one or more of the following components (or combinations thereof): at least one master gaming controller (MGC) 611, communication components 612, printer components 614, Bill/coin acceptor components 616, sensor components 618, data collection and reporting components 613.

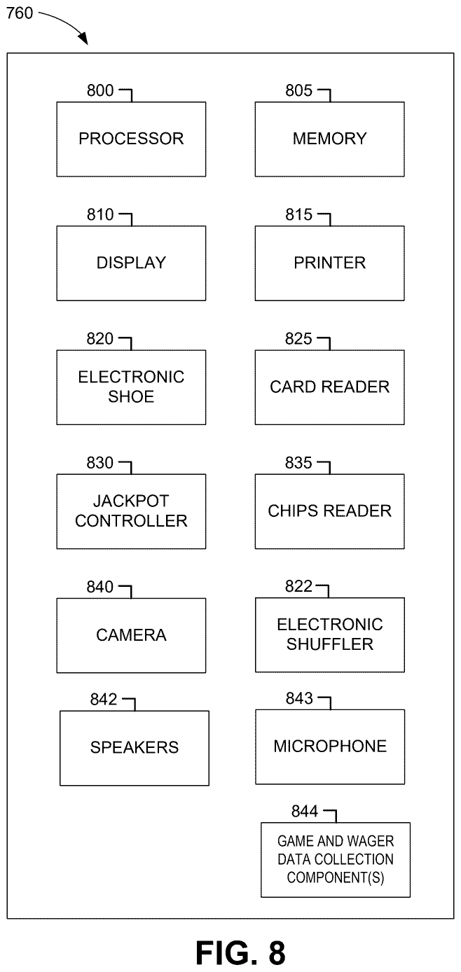

According to different embodiments, Gaming Tables(s) may include one or more of the following (or combinations thereof): traditional casino gaming tables (e.g., craps, baccarat at, blackjack, roulette, etc.), electronic gaming tables, server-based gaming tables, and/or other types of devices or components which provide capabilities for enabling two or more casino patrons to concurrently participate in gaming and/or wagering activities. As illustrated in the example embodiment of FIG. 6, one or more gaming tables may be configured or designed to include one or more of the following components (or combinations thereof): at least one master gaming controller (MGC) 621, communication components 622, printer components 624, Bill/voucher/coin acceptor components 626, sensor components 628, data collection and reporting components 623. In at least one embodiment data collection and reporting components 623 may include functionality for facilitating, enabling, initiating, and/or performing collection and reporting of game-related information and/or wager-related information (e.g., including financial transaction events) occurring at that gaming table. Additional gaming table features and functionalities are illustrated and described with respect to FIG. 8.

In at least one embodiment data collection and reporting components (e.g., 613, 623, 653, 656) may include functionality for facilitating, aggregating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and the like.

In at least one embodiment, Local Administration System 630 may include various types of devices or components (such as, for example, mobile devices 632, tablets 634, computer systems 636, etc.) which provide capabilities for enabling casino administrators to implement or perform administration of one or more aspects, components, systems, operations, and/or activities relating to a casino gaming network (e.g., 601). Additionally, local administrative access may be provided for the casino manager for configuring, registering, monitoring, analyzing, sending alerts, generating reports, etc., relating to ML and suspicious activities.

According to different embodiments, Remote Devices 670 may include various types of devices or components (such as, for example, smart phones 672, tablets 674, computer systems 676, etc.) which provide capabilities for enabling a remote user to remotely participate in gaming and/or wagering activities at a casino gaming network (e.g., 601). In at least one embodiment, one or more remote device components may also be used by remote casino administrators to implement or perform remote administration of one or more aspects, components, systems, operations, and/or activities relating to a casino gaming network (e.g., 601).

In at least one embodiment, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems. Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein. According to specific embodiments, multiple instances or threads of the Gaming Network processes and/or procedures may be concurrently implemented and/or initiated via the use of one or more processors and/or other combinations of hardware and/or hardware and software.

According to different embodiments, various different types of encryption/decryption techniques may be used to facilitate secure communications between devices, systems, and/or components of the Gaming Network(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Notable Integrity Protocol, uses RC4), AES (Advanced Encryption Standard), RSA, DSA, DH, NTRU, and ECC (elliptic curve cryptography), PKA (Private key Authentication), Device-Unique Secret Notable and other cryptographic notable data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Gaming Network of FIG. 6 is but one example from a wide range of Gaming Network embodiments which may be implemented. Other embodiments of the Gaming Network (not shown) may include additional, fewer and/or different components/features that those illustrated in the example Gaming Network embodiment of FIG. 6.

Generally, the automated money laundering detection and reporting techniques described herein may be implemented in hardware and/or hardware+software. Hardware and/or software+hardware hybrid embodiments of the automated money laundering detection and reporting techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

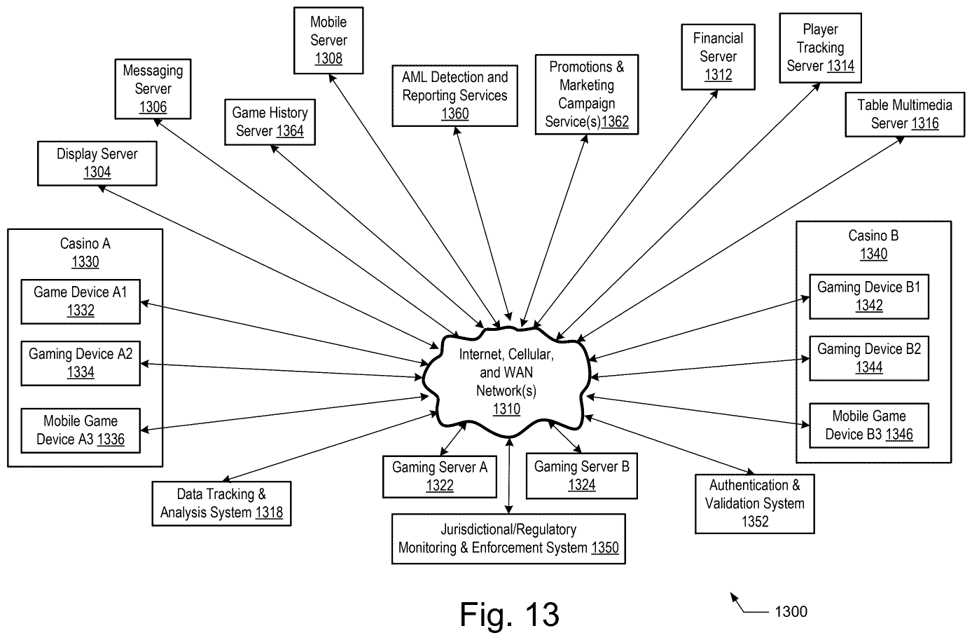

FIG. 13 illustrates an alternate example embodiment of a Gaming Network 1300 which may be configured or designed to implement various automated money laundering detection and reporting techniques described and/or referenced herein. As described in greater detail herein, different embodiments of Gaming Networks may be configured, designed, and/or operable to provide various different types of operations, functionalities, and/or features generally relating to Gaming Network technology. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 1300 may include a plurality of different types of components, devices, modules, processes, systems, etc., which, for example, may be implemented and/or instantiated via the use of hardware and/or combinations of hardware and software. For example, as illustrated in the example embodiment of FIG. 13, the Gaming Network may include one or more of the following types of systems, components, devices, processes, etc. (or combinations thereof):
Display Server System(s) 1304. Table Multimedia Server System(s) 1316.
Messaging Server System(s) 1306.
Mobile Server System(s) 1308.
AML Detection and Reporting Services 1360.
Promotions & Marketing Campaign Service(s) 1362.
Financial Server System(s) 1312.
Player Tracking Server System(s) 1314.
Data Tracking & Analysis System(s) 1318.
Gaming Server System(s) (922, 1324).
Jurisdictional/Regulatory Monitoring & Enforcement System(s) 1350.
Authentication & Validation System(s) 1352.
Casino Venues (930, 1340).
Electronic Game Devices (EGDs) 1332, 1334, 1336, 1342, 1344, 1346.
Internet, Cellular, and WAN Network(s) 1310.
Game History Server(s) 1364.
Remote Database System(s).
Remote Server System(s)/Service(s).
Mobile Device(s).
Etc.

Display Server System(s) (e.g., 1304). In at least one embodiment, the Display Server System(s) may be configured or designed to implement and/or facilitate management of content (e.g., graphics, images, text, video fees, etc.) to be displayed and/or presented at one or more EGDs (or at one or more groups of EGDs), dealer displays, administrator displays, etc.

Table Multimedia Server System(s) (e.g., 1316). In at least one embodiment, the Table Multimedia Server System(s) may be configured or designed to generate, implement and/or facilitate management of content (e.g., graphics, images, text, video fees, audio feeds, etc.), which, for example, is to be streamed or provided to one or more EGDs (or to one or more groups of EGDs).

Messaging Server System(s) (e.g., 1306). In at least one embodiment, the Messaging Server System(s) may be configured or designed to implement and/or facilitate management of messaging and/or other communications among and between the various systems, components, devices, EGDs, players, dealers, administrators, and/or other personnel of the gaming network.

Mobile Server System(s) (e.g., 1308). In at least one embodiment, the Mobile Server System(s) may be configured or designed to implement and/or facilitate management of communications and/or data exchanged with various types of mobile devices, including for example: player-managed mobile devices (e.g., smart phones, PDAs, tablets, mobile computers), casino-managed mobile devices (e.g., mobile gaming devices), etc.

AML Detection and Reporting Service(s) (e.g., 1360). In at least one embodiment, the AML Detection and Reporting Service(s) may be configured or designed to include functionality for facilitating, enabling, initiating, and/or performing various types of AML Detection and Reporting operation(s), action(s), and/or feature(s) such as one or more of those described herein.

Financial Server System(s) (e.g., 1312). In at least one embodiment, the Financial Server System(s) may be configured or designed to implement and/or facilitate tracking, management, reporting, and storage of financial data and financial transactions relating to one or more wager-based gaming sessions. For example, at least some Financial Server System(s) may be configured or designed to track of the game accounting (money in, money out) for a virtual table game being played, and may also be configured or designed to handle various financial transactions relating to player wagers and payouts. For example, in at least one embodiment, Financial Servers may be configured or designed to monitor each remote player's account information, and may also manage or handle funds transfers between each player's account and the active game server (e.g., associated with the player's game session).

Player Tracking Server System(s) (e.g., 1314). In at least one embodiment, the Player Tracking Server System(s) may be configured or designed to implement and/or facilitate management and exchange of player tracking information associated with one or more EGDs, gaming sessions, etc. In at least one embodiment, a Player Tracking Server System may include at least one database that tracks each player's hands, wins/losses, bet amounts, player preferences, etc., in the network. In at least one embodiment, the presenting and/or awarding of promotions, bonuses, rewards, achievements, etc., may be based on a player's play patterns, time, games selected, bet amount for each game type, etc. A Player Tracking Server System may also help establish a player's preferences, which assists the casino in their promotional efforts to: award player comps (loyalty points); award free game play credits, free/additional reel spin opportunities; decide which promotion(s) are appropriate; generate bonuses; etc.

Data Tracking & Analysis System(s) (e.g., 1318). In at least one embodiment, the Data Tracking & Analysis System(s) may be configured or designed to implement and/or facilitate management and analysis of game data. For example, in one embodiment the Data Tracking & Analysis System(s) may be configured or designed to aggregate multisite virtual game table trends, local wins, jackpots, etc.

Gaming Server System(s) (922, (e.g., 1324). In at least one embodiment, different game servers may be configured or designed to be dedicated to one or more specifically designated type(s) of game(s) (e.g., Baccarat, Black Jack, Poker, Mahjong, Pai-gow, Chess, etc.). Each game server has game logic to host one of more virtual table game sessions. At least some game server(s) may also capable of keeping track of the game accounting (money in, money out, games won, game lost, etc.) for a virtual table game being played, and/or for updating the Financial Servers at the end of each game. The game servers may also operable to generate the virtual table graphics primitives (e.g., game pieces and game states), and may further be operable to update the remote EGDs when a game state change (e.g., new card dealt, player upped the ante, player folds/busts, etc.) has been detected.

Jurisdictional/Regulatory Monitoring & Enforcement System(s) (e.g., 1350). In at least one embodiment, the Jurisdictional/Regulatory Monitoring & Enforcement System(s) may be configured or designed to handle tracking, monitoring, reporting, and enforcement of specific regulatory requirements relating to wager-based gameplay activities in one or more jurisdictions.

Authentication & Validation System(s) (e.g., 1352). According to different embodiments, the Authentication & Validation System(s) may be configured or designed to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a player tracking card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the Authentication & Validation System(s) may be configured or designed to authenticate and/or validate various types of hardware and/or software components, such as, for example, hardware/software components residing at a remote EGDs, game play information, wager information, player information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.

Game History Server(s) (e.g., 1364). In at least one embodiment, the Game History Server(s) may be configured or designed to track all (or selected) game types and game play history for all (or selected) virtual game tables. In at least one embodiment, a Game History Server may be configured or designed to assists the remote players in selecting a table by, for example, displaying the win/loss statistics of the tables selected by the player as potential candidates to participate. In some embodiments, a Game History Server may also assist the casino manager in case of disputes between players and the casino by, for example, providing the ability to “replay” (e.g., by virtually recreating the game events) the game in dispute, step by step, based on previously stored game states.

Promotions & Marketing Campaign Service(s) 1362 are integral to the casino's strategy for attracting and retaining patrons by offering a dynamic range of incentives and personalized marketing communications. These services leverage data analytics to understand patron behavior and preferences, enabling the creation of targeted promotions that resonate with specific customer segments. By offering tailored rewards, bonuses, and special events, these services enhance player satisfaction and loyalty, encouraging repeat visits and increased play. The services also encompass digital and traditional marketing campaigns, utilizing various channels to engage potential and existing customers effectively. The ability to dynamically adjust promotions in response to customer feedback and changing market conditions ensures that the casino remains competitive and responsive to player needs. Furthermore, these services provide desirable tools for measuring the effectiveness of marketing strategies, offering insights that drive continuous improvement and strategic decision-making in promotional activities.

The functionality of the various systems and components of FIG. 13 may be similar to those described previously with respect to the description of FIG. 6, and therefore need not be repeated.

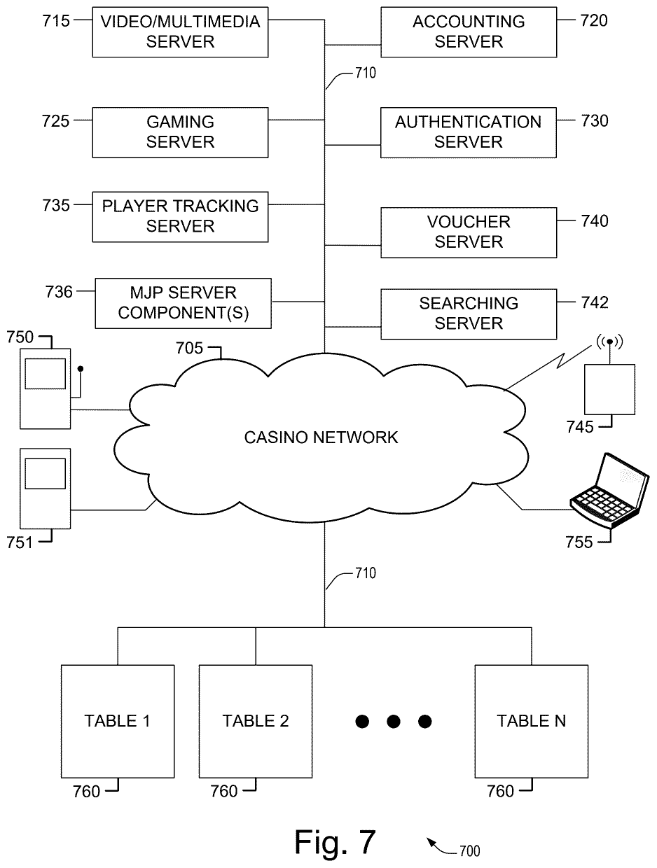

FIG. 7 shows an example block diagram of an electronic gaming system 700 in accordance with a specific embodiment. Electronic gaming system 700 may include electronic gaming tables 760, which may be coupled to network 705 via a network link 710. Electronic gaming tables 760 may be normal gaming tables with enhanced electronic capabilities. Network 705 may be the internet or a private network. One or more video streams may be received at video/multimedia server 715 from gaming tables 760. Video/Multimedia server 715 may transmit one or more of these video streams to a mobile device 745, a gaming device 750, an EGD 751, a laptop 755, and/or any other remote electronic device. Video/Multimedia server 715 may transmit these video streams via network link 710 and network 705.

Electronic gaming system 700 may include an accounting/transaction server 720, a gaming server 725, an authentication server 730, a player tracking server 735, a voucher server 740, and a searching server 742.

Accounting/transaction server 720 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 720 may generate tax information relating to these wagers. Accounting/transaction server 720 may generate profit/loss reports for predetermined gaming options, contingent gaming options, predetermined betting structures, and/or outcome categories.

Gaming server 725 may generate gaming options based on predetermined betting structures and/or outcome categories. These gaming options may be predetermined gaming options, contingent gaming options, and/or any other gaming option disclosed in this disclosure.

Authentication server 730 may determine the validity of vouchers, players' identity, and/or an outcome for a gaming event.

Player tracking server 735 may track a player's betting activity, a player's preferences (e.g., language, drinks, font, sound level, etc.). Based on data obtained by player tracking server 735, a player may be eligible for gaming rewards (e.g. free play), promotions, and/or other awards (e.g., complimentary food, drinks, lodging, concerts, etc.).

Voucher server 740 may generate a voucher, which may include data relating to gaming options. For example, data relating to the structure (e.g., 6 out of the next 10 rolls at craps table 4 will be a 7 or 11) may be generated. If there is a time deadline, that information may be generated by voucher server 740. Vouchers may be physical (e.g., paper) or digital.

The MJP Server Component(s) 736, located within the networked architecture of the Electronic Gaming System 700, function as the specialized processing nodes responsible for integrating live electronic table games (ETGs) into the wider Mystery Jackpot network. These components are specifically adapted to handle the unique data streams associated with table games, such as the discrete “Game End” signals from electronic shoes or shufflers. Their primary role is to synchronize the asynchronous nature of table gameplay (where rounds vary in length based on player decisions) with the synchronous requirements of a mystery jackpot event. The MJP Server Component(s) 736 act as a middleware layer, aggregating wager data from multiple table terminals and feeding it into the central “Wager Contribution System” to drive pool growth.

Technically, these components are responsible for executing the logic that determines table-specific eligibility. For example, they process the “Dealer Performance Tracker” data to determine if a specific table has met the “Hot Streak” criteria required to enable the manual jackpot trigger button on the dealer's console. Once a trigger is authorized, the MJP Server Component(s) 736 manage the distribution of the “Jackpot Event” video overlay to connected table displays and player terminals, ensuring that the live video feed of the dealer is perfectly synced with the digital jackpot animations. This server component effectively bridges the gap between physical table operations and digital reward systems, allowing for the implementation of features like “Splash Pots” where funds are dynamically redistributed to active players at a specific table based on real-time game outcomes.

Searching server 742 may implement a search on one or more gaming devices to obtain gaming data. Searching server 742 may implement a messaging function, which may transmit a message to a third party (e.g., a player) relating to a search, a search status update, a game status update, a wager status update, a confirmation of a wager, a confirmation of a money transfer, and/or any other data relating to the player's account. The message may take the form of a text display on the gaming device, a pop up window, a text message, an email, a voice message, a video message and the like. Searching server 742 may implement a wagering function, which may be an automatic wagering mechanism. These functions of searching server 742 may be integrated into one or more servers.

Searching server 742 may include one or more searching structures, one or more searching algorithms, and/or any other searching mechanisms. In general, the search structures may cover which table games paid out the most money during a time period, which table games kept the most money from players during a time period, which table games are most popular (top games), which table games are least popular, which table games have the most amount of money wager during a period, which table games have the highest wager volume, which table games are more volatile (volatility, or deviation from the statistical norms, of wager volume, wager amount, pay out, etc.) during a time period, and the like. Search may also be associated with location queries, time queries, and/or people queries (e.g., where are the table games that most of my friends wager on, where are my favorite dealers, what do players wager on the most today, when are most wagers placed, etc.).

The searching structures may be predetermined searching structures. For example, the method may start searching a first device, then a second device, then a third device, up to an Nth device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria.

Searching algorithms may be dynamic searching programs, which may be modified based on one or more past results. For example, a search algorithm may be based on searching blackjack tables. The search algorithm may initially search blackjack tables 1-10 to determine whether any triggering events have occurred. Based on one or more previous searches, the search algorithm may determine: (1) that blackjack tables 1-4 are only opened from 7 μm to 3 am; (2) that blackjack tables 5-7 are opened twenty-four hours a day; and (3) that blackjack tables 8-10 are only opened from 7 am to 5 μm. The search algorithm may then modify the search parameters utilized based on this data. For example, if the search algorithm is initiated at 6 μm to determine blackjack triggering events, then the search algorithm may only search blackjack tables 5-7 because these blackjack tables are the only blackjack tables operating at that specific time.

In another example, the search algorithm may determine that a specific triggering event occurs with a ninety percent success rate on a first table, a ten percent success rate on a second table, a fifty percent success rate on a third table, and a seventy percent success rate on a fourth table. The search algorithm may generate a search priority based on the probability of success, which may lead to the first table being searched first, the fourth table being searched second, the third table being searched third, and the second table being searched fourth. Search algorithm may utilize any dynamic feedback procedure to enhance current and/or future searching results

FIG. 8 shows electronic gaming table 760 with various features, in accordance with a specific embodiment. Various different embodiments of the electronic gaming table 760 may be used as a live game table for conducting gameplay relating to one or more gaming sessions.

Electronic gaming table 760 may include a processor 800, a memory 805, a display 810, a printer 815, an electronic shoe 820, an electronic shuffler 822, a smart card reader 825, a jackpot controller 830, a chips reader 835, and a camera 840.

Processor 800 may be communicatively coupled to any other device in electronic gaming table 760. Processor 800 via an interface may communicate wired or wireless, with any of the elements of electronic gaming device 900 and/or electronic gaming table system 700.

Memory 805 may include data relating to gaming events, video streams transmitted from electronic gaming table 760, winning and losing percentages for gaming options relating to electronic gaming table 760, and game management data (e.g., dealer schedule, chip refills, etc.).

Display 810 may show previous game results, a betting structure, outstanding wagers, transaction volume, present value of betting options, a table minimum wager, a table maximum wager, wager and/or game play instructions input by one or more remote players (e.g., via their respective EGDs), instructions to the live dealer/attendant relating to game play activities to be performed by the dealer/attendant, video data, and/or any other type of data or content.

Printer 815 may generate vouchers, promotional items, food tickets, event tickets, and/or lodging tickets. Vouchers may be physical (e.g., paper) or digital.

Electronic shuffler 822 may be configured or designed to automatically shuffle multiple decks of cards, and to track the relative order of each of the cards of the shuffled decks of cards. The electronic shuffler may include an off the shelf unit. A dealer may use the electronic shuffler to shuffle the decks of cards before dealing the required hands, and place the shuffled decks of cards into the electronic shoe 820. In this way, the electronic gaming table may determine the relative order of all cards in the card shoe at the start of one or more game session(s), and/or at all other times of game play.

Electronic shoe 820 may obtain data and/or images of gaming objects utilized with gaming table 760. This data and/or images may be transmitted to electronic gaming device and displayed as images from table games. For example, on a blackjack table a ten of spades may be dealt to a player. This information is obtained via electronic shoe 820 and utilized to generate an image and/or illustration of a ten of spades card on an electronic gaming device. In another example, electronic shoe 820 may receive data relating to the numbers on dice, transmit this data to electronic gaming device, which may be utilized to generate an image/illustration of the dice on electronic gaming device.

In at least one embodiment, the electronic shoe may include an electronic reading system, such as an optical reader for recognizing the face value of each card. The electronic shoe may be designed to communicate directly with the card dealing/shuffling system to read or otherwise obtain the value of each card being dealt by the dealer as the card leaves the card dealing/shuffling system. For example, an optical reader or similar device may be attached to the card dealing/shuffling system, and the electronic shoe may obtain the scanned value of cards in the card dealing/shuffling system. In some implementations, the electronic shoe may interface with the table to read the value of each card being dealt by the dealer. For example, the table may include one or more scanning interfaces to scan each card before or after the card is dealt by the dealer. The electronic shoe may communicate with the one or more scanning interfaces to obtain the value of each card before or after the card is dealt by the dealer.

Card reader 825 may provide identification, authentication, and application processing functions. Card reader 825 may interface with smart cards, magnetic striped card, bar code reader, RFID card, and the like.

Jackpot controller 830 may track and compile data associated with a jackpot. Jackpot controller 830 may award the jackpot on a specific occurrence (e.g., blackjack event, dealing a royal flush, etc.) and/or randomly award a jackpot.

Chips reader 835 may compile and track data associated with the amount of chips one or more players possesses, the amount of chips won/lost at gaming table 760, the amount of chips in the dealer's rack at gaming table 760, an amount of chips wager by one or more players, amount of chips in the betting pool, and/or any combination thereof.

Camera 840 may obtain data from gaming table 760. Camera 840 may be one or more cameras located to view the gaming objects (e.g., cards, dice, dominos, ball, wheel, etc.), the dealer, the shoe, the players' hands, the players, and/or any combination thereof. Camera 840 may transmit this data to gaming table, which may be utilized to generate an image/illustration of the gaming objects.

Speakers 842 may be used to provide audio information to the game table dealer/attendant. Examples of different types of audio information may include, for example, audio instructions and/or other audio/verbal communications from one or more remote players, computer-generated audio instructions/content, sound effects, and/or other types of audio content.

Microphone 843 may be used to capture, record, and/or stream audio information from the electronic gaming table region, which, for example, may include verbal communications from the table game dealer/attendant.

Game And Wager Data Collection Component(s) 844 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

According to specific embodiments, a variety of different game states may be used to characterize the state of current and/or past events which are occurring (or have occurred) at a given live gaming table. For example, in one embodiment, at any given time in a game, a valid current game state may be used to characterize the state of game play (and/or other related events, such as, for example, mode of operation of the gaming table, etc.) at that particular time. In at least one embodiment, multiple different states may be used to characterize different states or events which occur at the gaming table at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the gaming table may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming table. Examples of such entities may include, but are not limited to, one or more of the following (or combination thereof): master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the gaming table may be operable to automatically monitor game play activities at the gaming table, and/or to automatically identify notable events which may trigger a transition of game state from one state to another as a game progresses. For example, in the case of Blackjack, a notable event may include one or more events which indicate a change in the state of a game such as, for example: a new card being added to a card hand, the split of a card hand, a card hand being moved, a new card provided from a shoe, removal or disappearance of a card by occlusion, etc.

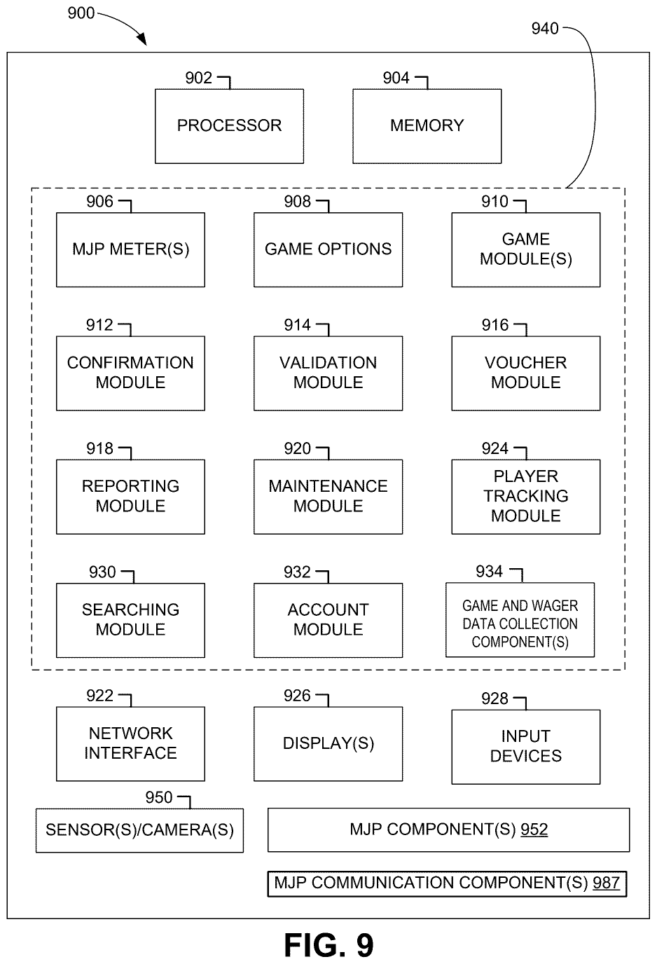

FIG. 9 shows a block diagram 900 of electronic gaming device 900, in accordance with a specific embodiment. Electronic gaming device 900 may include a processor 902, a memory 904, a network interface 922, input devices 928, and a display 926.

Processor 902 may generate gaming options based on predetermined betting structures and/or outcome categories. As previously discussed in the craps example above, predetermined betting structures may include outcome categories. In that example, there were three outcome categories (e.g., outcome equaling a seven, outcome not equaling a hard number, and outcome not equaling a craps). Predetermined betting structures may utilize one outcome category (e.g., win, lose, hard number, craps, etc.) to generate via processor 902 gaming options. Predetermined betting structures may utilize more than one outcome category to generate via processor 902 gaming options. Predetermined betting structures may combine any outcome category with any other outcome category to gaming options.

Processor 902 may generate gaming options 908, which, for example, may include contingent gaming options and/or predetermined gaming options. Contingent gaming options may be structures such that when a triggering event occurs over one or more than one gaming event, racing event, and/or sporting event, the wager is activated. Processor 902 may offer a gaming option which is structured so that the gaming option relates to more than one gaming table. The gaming option structure may be that for the next five baccarat games the dealer will win three of these five games and three of the next five roulette games red will be the winning spot.

In at least some embodiments, a predetermined game options module may store data relating to predetermined gaming options, which may be offered to a player, and a contingent game options module may store data relating to continent gaming options, which may be offered to a player.

Network interface 922 may be configured or designed to enable the electronic gaming device 900 to communicate with video/multimedia server(s), accounting/transaction server(s), gaming server(s), authentication server(s), player tracking server(s), voucher server(s), and gaming table(s).

Input devices 928 may be mechanical buttons, electronic buttons, a touchscreen, a microphone, cameras, an optical scanner, or any combination thereof. Input devices 928 may be utilized to make a wager, to make an offer to buy or sell a voucher, to determine a voucher's worth, to cash in a voucher, to modify (e.g., change sound level, configuration, font, language, etc.) electronic gaming device 900, to select a movie or music, to select live video streams (e.g., table 1, table 2, table 3), to request services (e.g., drinks, manager, etc.), or any combination thereof.

Display 926 may show video streams from one or more gaming tables 260, gaming objects from one or more gaming tables 260, computer generated graphics, predetermined gaming options 106, and/or contingent gaming options 108.

Memory 904 may include various memory modules 940. Memory 904 via various memory modules 940 may include a future betting module 906, a predetermined game options module 908, a contingent game options module 910, a confirmation module 912, a validation module 914, a voucher module 916, a reporting module 918, a maintenance module 920, a player tracking preferences module 924, a searching module 930, and an account module 932.

Confirmation module 912 may utilize data received from a voucher, the transaction history of the voucher (e.g., the voucher changed hands in a secondary market), and/or the identity of the player to confirm the value of the voucher. In another example, confirmation module 912 may utilize game event data, along with voucher data to confirm the value of the voucher.

Validation module 914 may utilize data received from a voucher to confirm the validity of the voucher.

Voucher module 916 may store data relating to generated vouchers, redeemed vouchers, bought vouchers, and/or sold vouchers.

Game And Wager Data Collection Component(s) 934 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

Sensor(s)/Camera(s) 950 may be configured or designed to detect and capture external data, events, and/or conditions including, for example, biometric information (e.g., facial images, facial features, fingerprints, voice recordings, etc.) relating to the player(s) or user(s) interacting with the gaming device. In some embodiments, the camera and/or other sensor(s) of the electronic gaming device may be remotely controlled and actuated. For example, in one embodiment, if it is determined that suspicious ML activities may be occurring at a given electronic gaming device, the camera of the electronic gaming device may be caused to be remotely actuated in order to capture a facial image of the person(s) who is/are interacting with the electronic gaming device.

Reporting module 918 may generate reports related to a performance of electronic gaming device 900, electronic gaming system, table game, video streams, gaming objects, credit device, and/or identification device.

In one implementation, reporting module 918 may reside on a central server and may aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 may be displayed publicly or privately. For example, popular trending and statistical information on wager volume and wager amount for the top ten table games may be publicly displayed in a casino display system so that players may study and decide what game to play, where, when, etc. Such a public display of general statistics may also be posted on the Internet, sent out as a text, an email, or multimedia message to the player's smart phones, tablets, desktop computer, etc. In another example, the trending and statistical information may also be distributed privately to privileged players such as casino club members.

Maintenance module 920 may track any maintenance that is implemented on electronic gaming device 900 and/or electronic gaming system 200. Maintenance module 920 may schedule preventative maintenance and/or request a service call based on a device error.

The Player Tracking Module 924 is a sophisticated component within the gaming system that monitors and records player activity during gaming sessions. This module is desirable for gathering data on player behavior, preferences, and gaming patterns. By tracking such activities, casinos may tailor their offerings and promotions to better suit individual player preferences, thereby enhancing the overall gaming experience. This module often works in conjunction with player loyalty programs, awarding points or credits based on gaming frequency, duration, and wager amounts. The insights gained from the Player Tracking Module 924 enable casinos to deliver personalized gaming experiences, incentivize repeat visits, and foster a deeper engagement with players. Moreover, this data is invaluable for optimizing game floor management, marketing strategies, and customer service initiatives, ultimately contributing to improved customer satisfaction and loyalty.

Player tracking module 924 may be configured or designed to communicate with the Casino's network-based player tracking system to retrieve player tracking data associated with the identified player and/or compile and track player tracking-related data including, for example, one or more of the following (or combinations thereof):
data associated with a players preferences;
game play activity
wagering activity;
earned rewards;
comps;
free game play opportunities;
free spin (and respin) opportunities;
MJP-related opportunities;
promotional offers;
non-game play activities conducted by that player/patron at the casino property such as, for example:
   shopping activities;
   dining activities;
   purchasing/spending activities;
   entertainment activities;
etc.

MJP Meter(s) 906 are integrated within the memory and display logic of the Electronic Gaming Device 900, serving as the localized register for mystery jackpot values. Within the context of the specialized EGD 900, these meters are designed to support “Future Betting” and “Contingent Game Options” by displaying potential future jackpot values or “Shadow Pools” that a player may buy into. Unlike standard meters that only show current values, MJP Meter(s) 906 may project “Predicted Growth” or display “Time-Limited” jackpot values associated with specific promotional windows.

These meters interact closely with the “Player Tracking Module” to render personalized meter values. For a high-tier player, the MJP Meter(s) 906 may display a “Boosted” jackpot amount (e.g., 1.5× the base value), reflecting the player's specific bonus eligibility. This personalization may require the meters to dynamically fetch data from the “Account Module” and applying local rendering logic to differentiate the display for the specific user. Furthermore, the MJP Meter(s) 906 are instrumental in the “Neighbor Luck Share” notification process, when a nearby device triggers a win, these meters instantly transition from displaying pool values to displaying “Neighbor Bonus” credit amounts, providing immediate visual confirmation of the communal win. This capability solves the problem of informing players of complex, multi-source payouts (base game+neighbor bonus+sponsor bonus) in a clear, integrated manner.

MJP Component(s) 952 are the resident functional modules within the Electronic Gaming Device 900 that execute the client-side logic for the Mystery Jackpot system. These components are distinct in their ability to interface with the “Sensor(s)/Camera(s) 950” to integrate biometric and environmental data into the jackpot eligibility logic. For instance, MJP Component(s) 952 utilize the camera feed to perform “Liveness Detection” or facial recognition, verifying that a valid player is physically present at the terminal before enabling eligibility for “Time-Based” or “Must-Hit-By” jackpots. This prevents “camping” or automated play fraud.

Functionally, these components also manage the “Augmented Reality” (AR) overlays associated with sponsored jackpots. When the device receives a “Sponsor Event” signal, the MJP Component(s) 952 retrieve media assets and render them as interactive layers over the base game screen. They handle the secure handshake with the “MJP Communication Component(s) 987” to report “Ad Impressions” or “Social Actions” (like scanning a QR code displayed on screen) back to the central server. By processing these interactions locally, the MJP Component(s) 952 reduce server load and ensure a responsive user experience, allowing for complex, media-rich jackpot events that function smoothly even during periods of high network traffic.

The MJP Communication Component(s) 987 serve as the dedicated network interface for all Mystery Jackpot-related data traffic entering and exiting the Electronic Gaming Device 900. Given the sensitive nature of jackpot triggers and the inclusion of external data sources (like social media or sponsors), these components implement robust security protocols, including “Unidirectional Data Flow” enforcement and “Payload Sanitization” for incoming messages. They are responsible for establishing and maintaining the persistent WebSocket or secure socket connections with the MJP Server, ensuring low-latency transmission of “State Lock” and “Trigger” signals.

Uniquely, the MJP Communication Component(s) 987 are designed to prioritize jackpot signaling over standard telemetry. In the event of network congestion, these components utilize “Quality of Service” (QoS) tagging to ensure that “Jackpot Win” packets are transmitted immediately, preventing the “Spoiler Effect” where a player sees a neighbor celebrate before their own machine registers the event. They also handle the encryption and signing of “Biometric/Identity Tokens” captured by the local sensors, creating a secure chain of custody for the data used to validate “Neighbor Luck Share” payouts. This component enables the EGD to function as a secure node in a distributed, hybrid-cloud gaming network, facilitating complex interactions like cross-machine synchronization and external API integration without compromising the security of the specific wagering loop.

Game Options 908 encompasses the variety of selectable settings and choices presented to players within a gaming machine. This component allows players to customize their gaming experience according to personal preferences, including adjusting bet amounts, selecting pay lines, and activating various game features relating to one or more of the MJP features disclosed herein. The availability of these options plays a notable role in enhancing player engagement by offering a sense of control over the game mechanics and outcomes. By enabling players to tailor the gameplay to their liking, Game Options 908 fosters a more immersive and enjoyable gaming environment. This customization feature is designed with the player in mind, ensuring that the gaming experience may be as dynamic and interactive as possible, thus encouraging prolonged play and increased satisfaction with the gaming experience.

Game Modules 910 refer to the specific components of the gaming system that execute the various games available on an Electronic Gaming Machine (EGM). These modules encompass the software and hardware elements necessary for the operation of games, including game logic, graphics, sound, and interactive features such as touch screen controls. Each module is responsible for delivering a distinct gaming experience, complete with unique themes, pay tables, bonus rounds, and, where applicable, MJP features. The modularity of these systems allows for a diverse gaming portfolio within a single EGM, offering players a wide range of entertainment options. Game Modules 910 are notable in maintaining player interest and engagement by providing fresh and varied gaming content. Additionally, they facilitate easy updates and integration of new games or features, ensuring that the gaming experience remains current and appealing to players.

Searching module 930 may include one or more searching structures, one or more searching algorithms, and/or any other searching mechanisms. The searching structures may be predetermined searching structures. For example, the method may start searching a first device, then a second device, then a third device, up to an Nth device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria. Searching algorithms may be dynamic searching programs, which may be modified based on one or more past results, as described previously.

In another example, the search algorithm may generate a search priority based on the probability of success various events and/or conditions, as described previously. In some embodiments, the search algorithm may utilize any dynamic feedback procedure to enhance current and/or future searching results.

Account module 932 may include data relating to an account balance, a wager limit, a number of wagers placed, credit limits, any other player information, and/or any other account information.

Data from account module 932 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

For example, the system and/or device determines via searching function that a triggering event has occurred. Based on this triggering event, the player would like to make a $400 wager, however, the player's account balance is only $50. In this case, the system and/or device may not accept the wager, modify the wager to the account balance (e.g., $50), send a notice to the player, modify the wager to some percentage (e.g., 10%, 25%, 50%, 75%, etc.) of the account balance (e.g., $5, $12.50, $25, $37.5, etc.), send a notice to the gaming entity, make a flat wager (e.g., $10), and/or any combination thereof.

In another example, the system and/or device determines via searching function that a triggering event has occurred. Based on this triggering event, the player would like to make a $400 wager and the player's account balance is $150. However, the system and/or device may not accept the wager because one betting parameter may be that no one wager may be more than a certain percentage (e.g., fifty percent) of a player's account balance. In this case, the system and/or device may not accept the wager, modify the wager to the predetermined limit (e.g., $75), send a notice to the player, modify the wager to some other percentage (e.g., 5%, 10%, 25%, 90%, etc.) of the account balance, send a notice to the gaming entity, make a flat wager (e.g., $10), and/or any combination thereof.

In another example, the gaming jurisdiction, the casino, the system and/or device may not allow an individual to place a wager over a specific value (e.g., $25, $400, $1,000, $10,000, $400,000, $1,000,000, etc.).

In another example, the system and/or device may not allow an individual to lose more than a specific amount of money in a predetermined timeframe. An individual may only be allowed to lose $200 (or any other number) over a two hour period (or any other time period).

In another example, based on this triggering event, the player would like to make a $400 wager and the player has a $200 balance. However, the player has made a predetermined number of wagers within a predetermined time frame. For example, the system and/or device may not allow an individual to make more than 5 wagers a day, 25 wagers a week, 1,000 wagers a year, etc.

Any of these betting parameters may be combined by the system and/or device.

In at least one embodiment, at least a portion of the modules discussed in block diagram 900 may reside locally in gaming terminal 900. However, In at least some embodiments, the functions performed by these modules may be implemented in one or more remote servers. For instance, modules 906-420 and 924 may each be on a remote server, communicating with gaming terminal 900 via a network interface such as Ethernet in a local or a wide area network topology. In some implementations, these servers may be physical servers in a data center. In some other implementations, these servers may be virtualized. In yet some other implementations, the functions performed by these modules may be implemented as web services. For example, the predetermined game options module 908 may be implemented in software as a web service provider. Gaming terminal 900 would make service requests over the web for the available predetermined wager options to be displayed. Regardless of how the modules and their respective functions are implemented, the interoperability with the gaming terminal 900 is seamless.

In one implementation, reporting module 918 may reside on a central server and may aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 may be displayed publicly or privately. For example, popular trending and statistical information on wager volume and wager amount for the top ten table games may be publicly displayed in a casino display system so that players may study and decide what game to play, where, when, etc. Such a public display of general statistics may also be posted on the Internet, sent out as a text, an email, or multimedia message to the player's smart phones, tablets, desktop computer, etc. In another example, the trending and statistical information may also be distributed privately to privileged players such as casino club members.

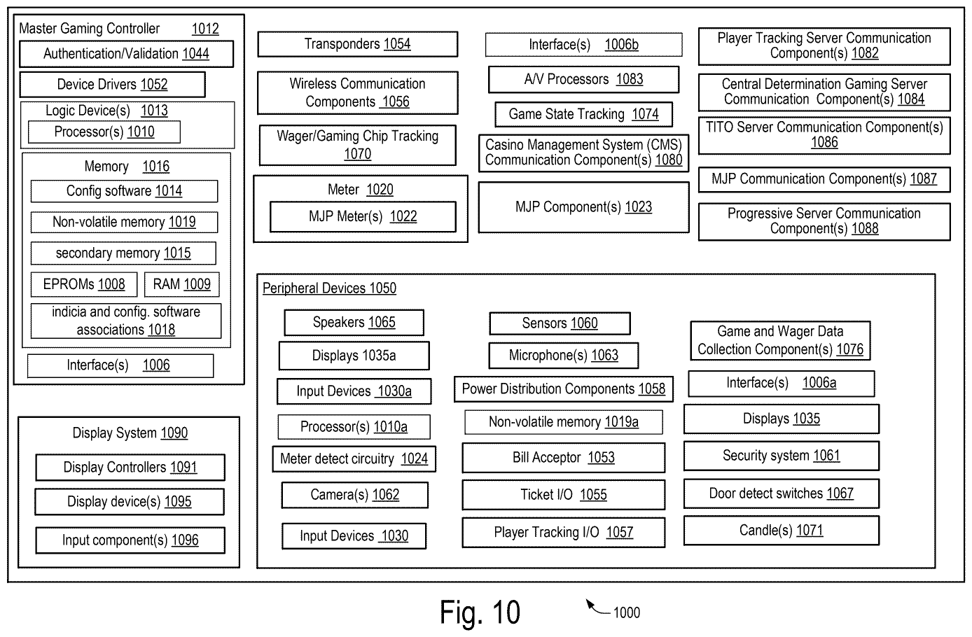

FIG. 10 is a simplified block diagram of an exemplary intelligent multi-player electronic gaming system 1000 in accordance with a specific embodiment. In some embodiments, gaming system by hundred may be implemented as a gaming server. In other embodiments, gaming system 1000 may be implemented as an electronic gaming machine (EGM) or electronic gaming device (EGD) or electronic gaming terminal (EGT).

As illustrated in the embodiment of FIG. 10, gaming system 1000 includes at least one processor 1010, at least one interface 1006, and memory 1016. Additionally, as illustrated in the example embodiment of FIG. 10, gaming system 1000 includes at least one master gaming controller 1012, a multi-touch sensor and display system 1090, a plurality of peripheral device components 1050, and various other components, devices, systems such as, for example, one or more of the following (or combinations thereof):
Transponders 1054;
Wireless communication components 1056;
Gaming chip/wager token tracking components 1070;
Games state tracking components 1074;
Audio/video processors 1083 which, for example, may include functionality for detecting, analyzing and/or managing various types of audio and/or video information relating to various activities at the gaming system.;
Various interfaces 1006 (e.g., for communicating with other devices, components, systems, etc.);
Sensors 1060;
One or more cameras 1062;
One or more microphones 1063;
Input devices 1030a;
Peripheral Devices 1050;
Game and Wager Data Collection Component(s) 1076

One or more cameras (e.g., 1062) may be used to monitor, stream and/or record image content and/or video content relating to persons or objects within each camera's view. For example, in at least one embodiment where the gaming system is implemented as an EGD, camera 1062 may be used to generate a live, real-time video feed of a player (or other person) who is currently interacting with the EGD. In some embodiments, camera 1062 may be used to verify a user's identity (e.g., by authenticating detected facial features), and/or may be used to monitor or tract facial expressions and/or eye movements of a user or player who is interacting with the gaming system.

In at least one embodiment, display system 1090 may include one or more of the following (or combinations thereof):
Display controllers 1091;
Multipoint sensing device(s) (e.g., multi-touch surface sensors/components);
Display device(s) 1095;
Input/touch surface 1096;
Etc.

According to various embodiments, display device(s) 1095 may include one or more display screens utilizing various types of display technologies such as, for example, one or more of the following (or combinations thereof): LCDs (Liquid Crystal Display), Plasma, OLEDs (Organic Light Emitting Display), TOLED (Transparent Organic Light Emitting Display), Flexible (F)OLEDs, Active matrix (AM) OLED, Passive matrix (PM) OLED, Phosphorescent (PH) OLEDs, SEDs (surface-conduction electron-emitter display), EPD (ElectroPhoretic display), FEDs (Field Emission Displays) and/or other suitable display technology. EPD displays may be provided by E-ink of Cambridge, MA. OLED displays of the type list above may be provided by Universal Display Corporation, Ewing, NJ.

In at least one embodiment, master gaming controller 1012 may include one or more of the following (or combinations thereof):
Authentication/validation components 1044;
Device drivers 1042;
Logic devices 1013, which may include one or more processors 1010;
Memory 1016, which may include one or more of the following (or combinations thereof): configuration software 1014, non-volatile memory 1015, EPROMS 1008, RAM 1009, associations 1018 between indicia and configuration software, etc.;
Interfaces 1006;

In at least one embodiment, Peripheral Devices 1050 may include one or more of the following (or combinations thereof):
Power distribution components 1058;
Non-volatile memory 1019a (and/or other types of memory);
Bill acceptor 1053;
Ticket I/O 1055;
Player tracking I/O 1057;
Meter detect circuitry 1024;
Processor(s) 1010a;
Interface(s) 1006a;
Display(s) 1035;
Security system 1061;
Door detect switches 1067;
Input devices 1030;
Etc.

EGM Meters 1020 provide real-time tracking and display of various game metrics such as credits, bets, wins, and more. These meters serve a dual purpose: offering players transparent insights into their current game status and enabling operators to monitor machine performance and compliance with gaming regulations. By presenting information clearly, EGM Meters help players make informed decisions about their gameplay, such as managing their bets and understanding their winnings. For operators, these meters facilitate efficient management of gaming operations by ensuring accuracy in transactions and gameplay integrity. The data collected through EGM Meters are also notable for analytical purposes, allowing for the optimization of game offerings and the enhancement of player experiences based on actual usage patterns and preferences.

MJP Meter(s) 1022, integrated into the Intelligent Multi-Player Electronic Gaming System 1000, represent advanced display units capable of handling multi-user and multi-state jackpot information. In a multi-player configuration, these meters are designed to display partitioned or “Community” jackpot values visible to all players at the station, as well as individual “Private” jackpot potential visible only on specific player segments of the display surface. This functionality supports the “Virtual Neighborhoods” concept, where players may see how their collective play is contributing to a shared pool.

The MJP Meter(s) 1022 interface with the “Multi-Touch Sensor and Display System” to allow for interactive query. A player may touch the meter to expand detailed information, such as “Contribution History,” “Sponsor Details,” or “Eligibility Rules.” This interactivity helps demystify the complex rules of dynamic jackpots for the player. Furthermore, these meters are synchronized with the “Motion/Gesture Detection Component(s),” allowing for visual responses (e.g., a pulse or glow) when a player performs a specific gesture or when the “Heat Level” of the station increases. By visualizing the algorithmic state of the jackpot engine-such as accelerating numbers during high-concurrency periods—the MJP Meter(s) 1022 actively drive player excitement and reinforce the communal nature of the gaming environment.

MJP Component(s) 1023 within the Intelligent Gaming System 1000 are high-performance logic modules responsible for the local execution of complex, multi-player mystery jackpot scenarios. These components are specifically optimized to handle the “Multi-Game State Synchronization” locally among the multiple player stations of a single gaming unit. When a jackpot event is broadcast, MJP Component(s) 1023 coordinate the “Lockout” and “Animation” states across all attached player interfaces simultaneously, ensuring a unified visual experience for the group.

Crucially, these components integrate with the “Wager/Gaming Chip Tracking” systems (like RFID surfaces) to determine real-time eligibility based on physical chip placement. They translate physical bet actions into digital “Participation Tokens” for the mystery jackpot. If a “Dealer-Controlled” jackpot is triggered, the MJP Component(s) 1023 instantly override the individual player screens to display the live video feed of the dealer, managing the transition from individual play to group spectating. They also execute the local logic for “Neighbor Luck Share” distribution within the multi-player unit, calculating and displaying split payouts to all active seats when one seat triggers the main prize. This local orchestration reduces reliance on the central server for micro-management of the multi-player station, improving system scalability.

The MJP Communication Component(s) 1087 in the Intelligent Gaming System 1000 facilitate the secure, high-bandwidth exchange of data required for media-rich mystery jackpot events. These components are configured to handle “Multi-Cast” messaging, allowing the system to efficiently receive a single “Jackpot Trigger” broadcast and distribute it to multiple player stations within the unit. They interface with the “Casino Management System (CMS)” and “Player Tracking Server” to fetch and validate player profiles in real-time, enabling the “Loyalty-Based Dynamic Odds” feature by transmitting session metrics (velocity, volume) to the central JOAE and receiving back personalized odds modifiers.

Additionally, the MJP Communication Component(s) 1087 support the “External Funding” mechanism by securely receiving “Asset Manifests” from the Ad Content Server. When a sponsored jackpot is active, these components ensure that the correct branding assets are downloaded and verified before display. They create a secure tunnel for “Social Media Integration” data, passing sanitized tokens related to player social actions (like sharing a win) to the internal game logic to unlock specific jackpot tiers. This component ensures that the complex web of internal and external data dependencies required for modem mystery jackpots is managed securely, maintaining compliance with gaming regulations regarding network isolation.

The Casino Management System (CMS) Communication Component(s) 1080 are notable in ensuring seamless interaction between gaming machines and the broader casino management infrastructure. These components facilitate the exchange of notable data regarding game performance, player activity, and machine status, enabling the CMS to effectively oversee and optimize the gaming floor. Through this communication, the CMS may implement changes in game configurations, update promotional offers, and monitor compliance with gaming regulations. Moreover, the data flow allows for the personalization of player experiences through targeted marketing and loyalty rewards, enhancing player satisfaction and retention. These components are desirable for maintaining the operational efficiency of casino operations, providing the backbone for real-time analytics, machine maintenance, and customer service initiatives, ultimately contributing to a superior gaming environment and improved profitability.

Player Tracking Server Communication Component(s) 1082 facilitate the notable exchange of data between gaming machines and the player tracking server, desirable for the implementation of loyalty programs and personalized gaming experiences. These components capture and transmit player activity data, including game play duration, bet amounts, and winnings, to the tracking server, which then analyzes this information to tailor rewards, offers, and communications to individual player preferences and behaviors. This targeted approach not only enhances player engagement by rewarding loyalty and encouraging repeat visits but also allows casinos to optimize their marketing strategies and improve overall customer satisfaction. By ensuring accurate and secure data transmission, these components play a notable role in maintaining the integrity of player tracking systems, supporting the delivery of customized gaming experiences that meet the unique needs and expectations of each player.

Central Determination Gaming Server Communication Component(s) 1084 are desirable for ensuring that Electronic Gaming Machines (EGMs) operate in compliance with gaming regulations that mandate centralized game outcome determination. These components enable secure and reliable communication between EGMs and the central determination gaming server, which is responsible for generating game outcomes based on a predetermined pool of results. This system ensures fairness and transparency in gaming by centralizing the outcome determination process, removing the randomness from individual machines, and complying with regulatory requirements. The communication components are notable for the seamless operation of this system, providing real-time connectivity that allows for immediate game outcome delivery to EGMs, ensuring a smooth and uninterrupted player experience. By facilitating this notable communication, these components uphold the integrity of the gaming operation and maintain player trust in the fairness of the game.

TITO Server Communication Component(s) 1086 play a notable role in the gaming ecosystem by enabling seamless interaction between Electronic Gaming Machines (EGMs) and the Ticket-In, Ticket-Out (TITO) server. These components ensure efficient and secure processing of TITO transactions, allowing players to easily cash out their winnings or move credits between machines. By facilitating the accurate exchange of data related to ticket validations, redemptions, and issuances, these communication components enhance the player experience by providing convenience and reducing wait times for ticket transactions. Furthermore, the integrity of the TITO system is maintained through the secure and reliable communication provided by these components, ensuring that all transactions are processed accurately, thereby preventing fraud and maintaining the trust of players in the gaming operation.

Progressive Server Communication Component(s) 1088 are desirable in linking Electronic Gaming Machines (EGMs) with the progressive server, which manages the accumulation and payout of progressive jackpots. These components ensure real-time, secure communication of data related to jackpot contributions and awards, enabling the seamless update and display of progressive jackpot values across the networked machines. By facilitating accurate and timely information exchange, these communication components play a notable role in maintaining the excitement and attractiveness of progressive jackpot games, where the potential for life-changing wins adds a significant draw for players. Moreover, the integrity of the progressive jackpot system is upheld through the reliable operation of these components, ensuring that jackpots are awarded correctly and transparently, thereby fostering player confidence in the fairness and reliability of the gaming operation.

In one implementation, processor 1010 and master gaming controller 1012 are included in a logic device 1013 enclosed in a logic device housing. The processor 1010 may include any conventional processor or logic device configured to execute software allowing various configuration and reconfiguration tasks such as, for example: a) communicating with a remote source via communication interface 1006, such as a server that stores authentication information or games; b) converting signals read by an interface to a format corresponding to that used by software or memory in the gaming system; c) accessing memory to configure or reconfigure game parameters in the memory according to indicia read from the device; d) communicating with interfaces, various peripheral devices and/or I/O devices; e) operating peripheral devices such as, for example, card readers, paper ticket readers, etc.; f) operating various I/O devices such as, for example, displays 1035, input devices 1030; etc. For instance, the processor 1010 may send messages including game play information to the displays 1035 to inform players of cards dealt, wagering information, and/or other desired information.

In at least one implementation, the gaming system may include card readers such as used with credit cards, or other identification code reading devices to allow or may require player identification in connection with play of the card game and associated recording of game action. Such a player identification interface may be implemented in the form of a variety of magnetic card readers commercially available for reading a player-specific identification information. The player-specific information may be provided on specially constructed magnetic cards issued by a casino, or magnetically coded credit cards or debit cards frequently used with national credit organizations such as VISA, MASTERCARD, AMERICAN EXPRESS, or banks and other institutions.

The gaming system may include other types of participant identification mechanisms which may use a fingerprint image, eye blood vessel image reader, or other suitable biological information to confirm identity of the player. Still further it is possible to provide such participant identification information by having the dealer manually code in the information in response to the player indicating his or her code name or real name. Such additional identification may also be used to confirm credit use of a smart card, transponder, and/or player's personal player input device (UID).

The gaming system 1000 also includes memory 1016 which may include, for example, volatile memory (e.g., RAM 1009), non-volatile memory 1019 (e.g., disk memory, FLASH memory, EPROMs, etc.), unalterable memory (e.g., EPROMs 1008), etc. The memory may be configured or designed to store, for example: 1) configuration software 1014 such as all the parameters and settings for a game playable on the gaming system; 2) associations 1018 between configuration indicia read from a device with one or more parameters and settings; 3) communication protocols allowing the processor 1010 to communicate with peripheral devices and I/O devices 1011; 4) a secondary memory storage device 1015 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming system to communicate with local and non-local devices using such protocols; etc. In one implementation, the master gaming controller 1012 communicates using a serial communication protocol. A few examples of serial communication protocols that may be used to communicate with the master gaming controller include but are not limited to USB, RS-232 and Netplex (a proprietary protocol developed by IGT, Reno, NV).

A plurality of device drivers 1042 may be stored in memory 1016. Example of different types of device drivers may include device drivers for gaming system components, device drivers for gaming system components, etc. Typically, the device drivers 1042 utilize a communication protocol of some type that enables communication with a particular physical device. The device driver abstracts the hardware implementation of a device. For example, a device drive may be written for each type of card reader that may be potentially connected to the gaming system. Examples of communication protocols used to implement the device drivers include Netplex, USB, Serial, Ethernet 1075, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 1016 by the processor 1010 to allow communication with the device. For instance, one type of card reader in gaming system 1000 may be replaced with a second type of card reader where device drivers for both card readers are stored in the memory 1016.

In some embodiments, the software units stored in the memory 1016 may be upgraded as needed. For instance, when the memory 1016 is a hard drive, new games, game options, various new parameters, new settings for existing parameters, new settings for new parameters, device drivers, and new communication protocols may be uploaded to the memory from the master gaming controller 1012 or from some other external device. As another example, when the memory 1016 includes a CD/DVD drive including a CD/DVD designed or configured to store game options, parameters, and settings, the software stored in the memory may be upgraded by replacing a first CD/DVD with a second CD/DVD. In yet another example, when the memory 1016 uses one or more flash memory 1019 or EPROM 1008 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming system 1000 may also include various authentication and/or validation components 1044 which may be used for authenticating/validating specified gaming system components such as, for example, hardware components, software components, firmware components, information stored in the gaming system memory 1016, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Sensors 1060 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; etc.

In one implementation, at least a portion of the sensors 1060 and/or input devices 1030 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming system player may include input functionality for enabling players to provide their game play decisions/instructions (and/or other input) to the dealer using the touch keys and/or other player control sensors/buttons. Additionally, such input functionality may also be used for allowing players to provide input to other devices in the casino gaming network (such as, for example, player tracking systems, side wagering systems, etc.)

Wireless communication components 1056 may include one or more communication interfaces having different architectures and utilizing a variety of protocols such as, for example, 802.11 (WiFi), 802.15 (including Bluetooth™) 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication-Interface and Protocol (NFCIP-1)”, published by ECMA International (www.ecma-intemational.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least two devices using such wireless communication protocols.

Power distribution components 1058 may include, for example, components or devices which are operable for providing wireless power to other devices. For example, in one implementation, the power distribution components 1058 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

In at least one embodiment, motion/gesture detection component(s) 1051 may be configured or designed to detect player (e.g., player, dealer, and/or other persons) movements and/or gestures and/or other input data from the player. In some embodiments, each gaming system may have its own respective motion/gesture detection component(s). In other embodiments, motion/gesture detection component(s) 1051 may be implemented as a separate sub-system of the gaming system which is not associated with any one specific gaming system or device.

Game And Wager Data Collection Component(s) 1076 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

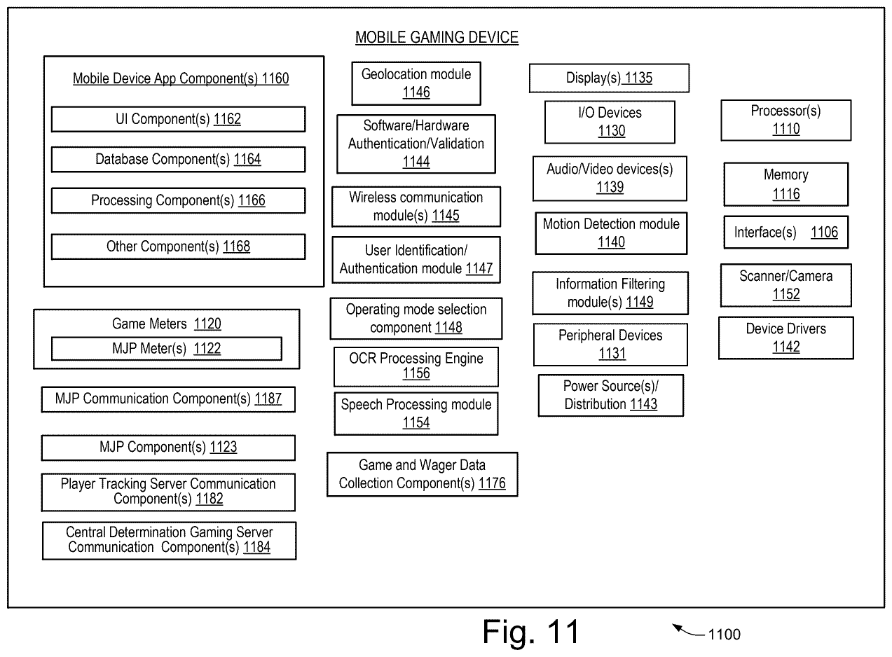

FIG. 11 is a simplified block diagram of an example mobile gaming device 1100 in accordance with a specific embodiment. In at least one embodiment, one or more players may participate in a live, multiplayer, wager-based, virtual table game session using mobile gaming devices. In at least some embodiments, the mobile gaming device may be configured or designed to include or provide functionality which is similar to that of an electronic gaming device (EGD) such as that described, for example, in FIGS. 9 and 10.

As illustrated in the example of FIG. 11, mobile gaming device 1100 may include a variety of components, modules and/or systems for providing various functionality. For example, as illustrated in FIG. 11, mobile gaming device 1100 may include Mobile Device Application components (e.g., 1160), which, for example, may include, but are not limited to, one or more of the following (or combinations thereof):
UI Components 1162 such as those illustrated, described, and/or referenced herein.
Database Components 1164 such as those illustrated, described, and/or referenced herein.
Processing Components 1166 such as those illustrated, described, and/or referenced herein.
Other Components 1168 which, for example, may include components for facilitating and/or enabling the mobile gaming device to perform and/or initiate various types of operations, activities, functions such as those described herein.

In at least one embodiment, the mobile gaming device may include Mobile Device App Component(s) which have been configured or designed to provide functionality for enabling or implementing at least a portion of the various automated money laundering detection and reporting techniques at the mobile gaming device.

According to specific embodiments, various aspects, features, and/or functionalities of the mobile gaming device may be performed, implemented and/or initiated by one or more of the following types of systems, components, systems, devices, procedures, processes, etc. (or combinations thereof):
Processor(s) 1110
Device Drivers 1142
Memory 1116
Interface(s) 1106
Power Source(s)/Distribution 1143
Geolocation module 1146
Display(s) 1135
I/O Devices 1130
Audio/Video devices(s) 1139
Peripheral Devices 1131
Motion Detection module 1140
User Identification/Authentication module 1147
Client App Component(s) 1160
Other Component(s) 1168
UI Component(s) 1162
Database Component(s) 1164
Processing Component(s) 1166
Software/Hardware Authentication/Validation 1144
Wireless communication module(s) 1145
Information Filtering module(s) 1149
Operating mode selection component 1148
Speech Processing module 1154
Scanner/Camera 1152
OCR Processing Engine 1156
Game and Wager Data Collection Component(s) 1176

Game Meters 1120 are notable display components within Electronic Gaming Machines (EGMs), tasked with presenting various game-related statistics such as current credit balance, bet amounts, winnings, and more. These meters provide players with immediate, clear information about their game status, facilitating informed gaming decisions. The transparency afforded by these meters is desirable for a trustworthy gaming experience, allowing players to monitor their progress and manage their resources effectively. Beyond player benefits, Game Meters 1120 assist casino operators in ensuring gaming integrity and regulatory compliance by accurately tracking and reporting desirable game metrics. The real-time data captured by these meters also offer valuable insights for casino management, enabling the optimization of gaming operations and the tailoring of promotions to player behaviors and preferences. Essentially, Game Meters 1120 bridge the information gap between the gaming machine's internal mechanics and the player's understanding, enhancing the gaming experience for all parties involved.

MJP Meter(s) 1122 are software-defined display elements rendered on the user interface of a Mobile Gaming Device 1100. Unlike physical LED meters, these are highly adaptive graphical widgets that float over the game UI or live video feed. They are designed to address the limited screen real estate of mobile devices while communicating complex jackpot states. MJP Meter(s) 1122 may toggle between displaying the “Global Pool” value and the user's “Personal Potential Win,” which may differ based on their “Loyalty Tier” or “Social Eligibility.”

These meters support the “Dynamic Acceleration” visualization by utilizing animation frameworks to create “Fire” or “Lightning” effects that intensify as the global player count rises, giving remote players a visceral sense of the casino floor's energy. They also feature interactive elements; tapping the meter may reveal a “Quest Log” showing progress toward unlocking an exclusive jackpot pool (e.g., “Bet $50 more to unlock Platinum Pot”). Crucially, MJP Meter(s) 1122 integrate with the device's notification system to provide “Push Alerts” when a jackpot reaches an important threshold or when a “Neighbor Share” is won, drawing the player back into the app even when it is backgrounded.

MJP Component(s) 1123 are the client-side software libraries embedded within the Mobile Gaming Device application that manage the logic and state of Mystery Jackpot features. These components are responsible for the “Context-Aware” behavior of the app. For instance, they interface with the “Geolocation Module” to validate that the player is within a specific legal jurisdiction or even a specific physical zone (like a “Geofenced Casino Resort”) to enable location-specific jackpot pools. This allows for hybrid experiences where a mobile player standing in the casino lobby has access to different jackpots than one at home.

Functionally, MJP Component(s) 1123 manage the “Virtual Neighbor” logic. They maintain the “Virtual Seat” assignment data, tracking which other remote or local players are logically “adjacent” to the user in the game lobby. When a jackpot event occurs, these components handle the reception of the “Win” signal and orchestrate the “Celebration Mode” on the device, synchronizing haptic feedback (vibration) and audio cues with the server-side event. They also secure the mobile-to-server interactions, ensuring that “Social Share” callbacks are legitimately generated by user interaction and not simulated by bots, preserving the integrity of the “Social-to-Earn” mechanics.

MJP Communication Component(s) 1187 act as the secure network layer for the Mobile Gaming Device, managing connectivity over potentially unstable public networks (cellular/WiFi). They implement “Jitter Buffering” and “State Reconciliation” protocols to handle network latency during synchronized jackpot events. If the mobile device lags behind the live dealer feed, these components ensure that the “Jackpot Win” notification is held and displayed in correct sequence with the video stream, preventing spoilers.

These components facilitate the “Two-Way” interaction required for Dealer-Controlled Jackpots. When a live dealer initiates a jackpot, the MJP Communication Component(s) 1187 receive the “Lock” command and immediately disable the local betting UI to ensure the remote player cannot place invalid bets during the event. Conversely, they transmit “Player Activity” metrics (taps, shares, viewing time) back to the server to feed the “Player Activity Tracker,” ensuring the remote player's presence contributes to the “Dynamic Acceleration” of the global jackpot pool. They also handle the secure transmission of “Sponsor Tokens,” allowing the mobile app to display targeted ads that directly fund the jackpot pool the player is competing for.

Player Tracking Server Communication Component(s) 1182 are desirable for the efficient and secure exchange of data between gaming machines and the player tracking server. This communication is notable for implementing sophisticated player loyalty programs and delivering a personalized gaming experience. By accurately capturing and transmitting detailed information on player behavior, preferences, and activities at the gaming machines, these components enable the player tracking server to analyze data and tailor rewards, promotions, and communications to individual player profiles. The result is a highly engaging and rewarding casino experience that encourages player loyalty and repeat visits. The reliability and security of these communication components ensure that player data is handled with the utmost integrity, maintaining player trust and compliance with data protection regulations. Through the facilitation of targeted rewards and personalized gaming experiences, Player Tracking Server Communication Component(s) 1182 play a notable role in enhancing player satisfaction and casino profitability.

Central Determination Gaming Server Communication Component(s) 1184 ensure the flawless and secure transmission of game outcome data between the central determination gaming server and individual gaming machines. This system, notable for jurisdictions that may require game outcomes to be determined centrally rather than by the individual machine, guarantees fairness and compliance with gaming regulations. These communication components are notable for the integrity of the gaming experience, as they allow for real-time delivery of predetermined game outcomes to machines, ensuring that each player's experience is both random and compliant with regulatory standards. By maintaining a consistent and secure line of communication, these components ensure that the gaming experience remains seamless for players, without noticeable delays or discrepancies in game play. The Central Determination Gaming Server Communication Component(s) 1184 thus play a notable role in upholding the trust and confidence of players in the fairness and reliability of the gaming operation.

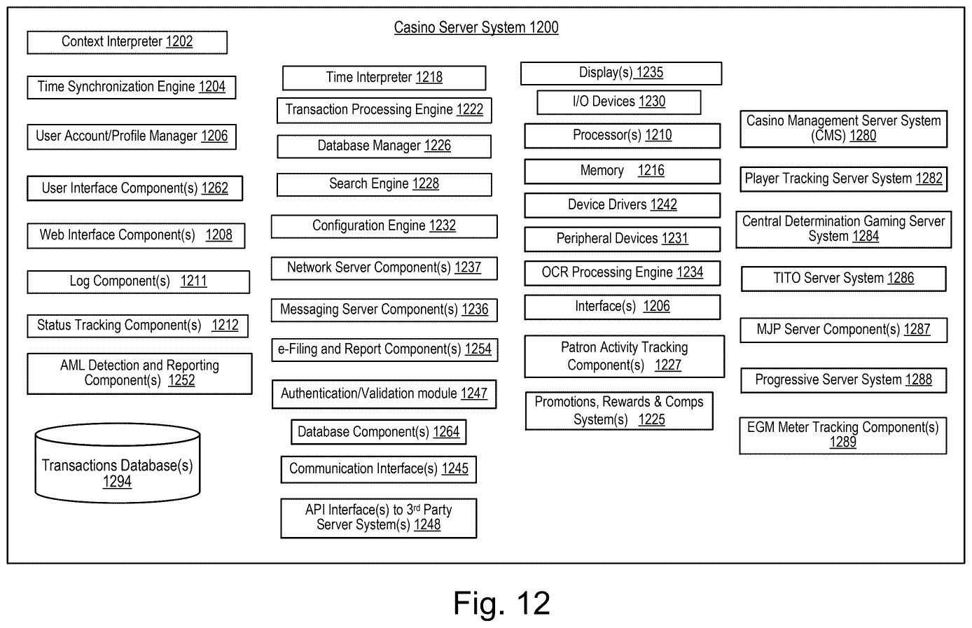

FIG. 12 illustrates an example of a functional block diagram of a Casino Server System in accordance with a specific embodiment. In at least one embodiment, the Casino Server System may be operable to perform and/or implement various types of functions, operations, actions, and/or other features, such as, for example, one or more of those described and/or referenced herein.

In at least one embodiment, the Casino Server System may include a plurality of components operable to perform and/or implement various types of functions, operations, actions, and/or other features such as, for example, one or more of the following (or combinations thereof):
Context Interpreter (e.g., 1202) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of mobile gaming device, geolocation of EGD, etc.)
   time-based criteria
   identity of user(s)
   user profile information
   transaction history information
   recent user activities
   etc.
Time Synchronization Engine (e.g., 1204) which, for example, may be operable to manages universal time synchronization (e.g., via NTP and/or GPS)
Search Engine (e.g., 1228) which, for example, may be operable to search for transactions, logs, game history information, player information, automated money laundering detection and reporting information, etc., which may be accessed from one or more local and/or remote databases.
Configuration Engine (e.g., 1232) which, for example, may be operable to determine and handle configuration of various customized configuration parameters for one or more devices, component(s), system(s), process(es), etc.
Time Interpreter (e.g., 1218) which, for example, may be operable to automatically and/or dynamically modify or change identifier activation and expiration time(s) based on various criteria such as, for example, time, location, transaction status, etc.
Authentication/Validation Component(s) (e.g., 1247) (password, software/hardware info, SSL certificates) which, for example, may be operable to perform various types of authentication/validation tasks such as one or more of those described and/or referenced herein.
Transaction Processing Engine (e.g., 1222) which, for example, may be operable to handle various types of transaction processing tasks such as, for example, one or more of those described and/or referenced herein.
OCR Processing Engine (e.g., 1234) which, for example, may be operable to perform image processing and optical character recognition of images such as those captured by a gaming device camera, for example.
Database Manager (e.g., 1226) which, for example, may be operable to handle various types of tasks relating to database updating, database management, database access, etc. In at least one embodiment, the Database Manager may be operable to manage game history databases, player tracking databases, etc.
Log Component(s) (e.g., 1211) which, for example, may be operable to generate and manage transactions history logs, system errors, connections from APIs, etc.
Status Tracking Component(s) (e.g., 1212) which, for example, may be operable to automatically and/or dynamically determine, assign, and/or report updated transaction status information based, for example, on the state of the transaction.
Gateway Component(s) (e.g., 1214) which, for example, may be operable to facilitate and manage communications and transactions with external Payment Gateways.
Web Interface Component(s) (e.g., 1208) which, for example, may be operable to facilitate and manage communications and transactions with virtual live game table web portal(s).
API Interface(s) to Casino Server System(s) (e.g., 1246) which, for example, may be operable to facilitate and manage communications and transactions with API Interface(s) to Server System(s) of various casino networks.
API Interface(s) to 3rd Party Server System(s) (e.g., 1248) which, for example, may be operable to facilitate and manage communications and transactions with API Interface(s) to 3rd Party Server System(s)
At least one processor 1210. In at least one embodiment, the processor(s) 1210 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of a gaming system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 1216, which, for example, may include volatile memory (e.g., RAM), non-volatile memory (e.g., disk memory, FLASH memory, EPROMs, etc.), unalterable memory, and/or other types of memory. In at least one implementation, the memory 1216 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile gaming system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein.
Interface(s) 1206 which, for example, may include wired interfaces and/or wireless interfaces. In at least one implementation, the interface(s) 1206 may include functionality similar to at least a portion of functionality implemented by one or more computer system interfaces such as those described herein and/or generally known to one having ordinary skill in the art.
Device driver(s) 1242. In at least one implementation, the device driver(s) 1242 may include functionality similar to at least a portion of functionality implemented by one or more computer system driver devices such as those described herein and/or generally known to one having ordinary skill in the art.
One or more display(s) 1235.
Messaging Server Component(s) 1236, which, for example, may be configured or designed to provide various functions and operations relating to messaging activities and communications.
Network Server Component(s) 1237, which, for example, may be configured or designed to provide various functions and operations relating to network server activities and communications.
AML Detection and Reporting Component(s) 1252. In at least one embodiment, the AML Detection and Reporting components may be configured or designed to include functionality for facilitating, aggregating data, enabling, initiating, and/or performing various types of financial transaction analysis, AML analysis and detection, and reporting operation(s), action(s), and/or feature(s) such as one or more of those described herein.
E-Filing and Report Component(s) 1254. In at least one embodiment, the e-Filing and Report Component(s) may be configured or designed to include functionality for facilitating, enabling, initiating, and/or performing various types of reporting and notification activities such as, for example:
   automated electronic filing of detected suspicious ML activities at appropriate governmental agencies;
   automated generation and/or transmission of notifications and alerts (e.g., such as those relating to detected suspicious ML activities) to appropriate authorities (e.g., police, Federal agencies, local law enforcement, casino security personnel, casino employees, etc.);
   and/or other types of types of reporting and notification activities such as those described herein.
Suspicious Activity/ML Activity Pattern Database(s). In at least one embodiment, the Suspicious Activity/ML Activity Pattern Database(s) may be configured or designed to include functionality for storing and/or providing access to various types of information relating to suspicious activity pattern and ML pattern analysis and detection, and/or other types of information described and/or referenced herein.
Transactions Database(s) 1294. In at least one embodiment, the Transactions Database(s) may be configured or designed to include functionality for storing and/or providing access to various types of information, events, and/or conditions such as, for example, one or more of the following (or combinations thereof): casino-related information, game play information, wager information, financial transaction information, and/or other types of information described and/or referenced herein.

Patron Activity Tracking Component(s) 1227 are notable for casinos aiming to offer a personalized and engaging gaming experience. These components meticulously collect data on every aspect of a patron's activities within the casino, from gaming habits to transaction history and participation in promotional events. This comprehensive data collection allows for deep insights into patron preferences and behavior, enabling casinos to tailor services, offers, and communications effectively. The utilization of this data significantly enhances customer relationship management strategies, promoting increased customer loyalty and satisfaction. By identifying trends and preferences, casinos may optimize their gaming floor, adjust their marketing strategies, and develop targeted promotions that resonate with their patrons. Furthermore, these tracking components are desirable for responsible gaming initiatives, allowing casinos to monitor player behavior for signs of problematic gaming patterns and intervene when necessary.

Promotions, Rewards & Comps System(s) 1225 are designed to enrich the casino experience for patrons by offering a variety of incentives that reward gaming activity and loyalty. These systems manage the distribution of promotions, rewards, and complimentary services or items to patrons based on their level of engagement and play. Through a strategic blend of immediate rewards, tiered loyalty programs, and targeted promotions, these systems encourage continued patronage by enhancing the perceived value of gaming and visits. The dynamic nature of these systems allows for customization and adaptation to patron preferences, ensuring that offers remain relevant and appealing. Additionally, they serve as a powerful marketing tool, driving foot traffic, increasing play time, and promoting higher spending. Effective management of these systems fosters a sense of appreciation among patrons, bolstering loyalty, and creating a competitive edge in the gaming and entertainment industry.

The Casino Management Server System (CMS) 1280 is the technological backbone of modem casino operations, orchestrating the seamless integration of gaming machines, patron management, financial transactions, and regulatory compliance. This centralized system provides a comprehensive suite of tools for managing every aspect of the casino floor, including game monitoring, accounting, security, and customer relations. By aggregating data from various sources, the CMS offers valuable insights into operational efficiency, player behavior, and revenue generation. This enables casino operators to make informed decisions, optimize game offerings, and personalize player experiences. The CMS also plays a notable role in ensuring compliance with gaming regulations, facilitating audits, and maintaining data security. Its scalable and modular design allows for flexibility and growth, ensuring that casinos may adapt to evolving market demands and technological advancements, thereby maintaining operational excellence and competitive advantage.

The Player Tracking Server System 1282 is a dedicated platform that centralizes the collection, analysis, and application of data related to casino patrons' gaming behaviors and preferences. This system is instrumental in supporting loyalty programs, enabling casinos to recognize and reward frequent players with offers tailored to their interests and play patterns. By leveraging detailed analytics, the Player Tracking Server System enhances customer engagement strategies, driving repeat business and increasing player satisfaction. It allows casinos to segment their customer base effectively, delivering personalized promotions, events invitations, and comps that resonate with individual preferences. Additionally, this system provides notable insights for optimizing game floor layouts, promotional offerings, and operational strategies. Its role in fostering strong customer relationships and loyalty is invaluable, directly impacting the casino's bottom line by promoting a loyal and engaged patron base.

The Central Determination Gaming Server System 1284 is a specialized server that centralizes the outcome determination for gaming machines, ensuring fairness and compliance with regulatory standards that mandate central random number generation. This system is notable in jurisdictions where gaming outcomes must not be determined by the individual machines but instead by a centralized, secure, and auditable source. By pooling the outcomes, the Central Determination Gaming Server System guarantees that each play is random and unbiased, reinforcing the integrity of the gaming experience. This system supports a variety of games and may be dynamically updated to introduce new content, maintaining player interest and engagement. Additionally, it provides casinos with the ability to monitor and manage the performance of games in real-time, optimizing their offerings and maximizing revenue while ensuring compliance with gaming regulations.

The TITO (Ticket-In, Ticket-Out) Server System 1286 is an desirable component of casino operations, facilitating the efficient and secure handling of paper-based transactions within the gaming environment. This system manages the issuance, acceptance, and validation of TITO vouchers, streamlining the process for both patrons and casino staff. By eliminating the need for physical coins or tokens, the TITO Server System enhances the customer experience, reducing wait times for machine refills and cashier interactions. It also improves operational efficiency by automating cash flow management and reducing machine downtime. The system's robust security features prevent fraud and duplication of vouchers, ensuring the integrity of transactions. Additionally, the TITO Server System collects transactional data, providing valuable insights into player behavior and machine performance, which may be used to optimize floor operations and marketing strategies.

MJP Server Component(s) 1287 represent the specific backend services within the Casino Server System 1200 specifically dedicated to the administration and execution of the Mystery Jackpot logic. These components are the authoritative source for the “Jackpot State.” They continuously run the “Jackpot Odds Adjustment Engine” algorithms, processing streams of player data to calculate personalized “Probability Modifiers” for every active session. They also host the “Fund Redistribution Engine,” executing the financial transactions required to repurpose expired or unclaimed jackpot funds into active pools according to regulatory rules.

Integration-wise, MJP Server Component(s) 1287 act as the central hub connecting the “Third-Party Sponsor System,” “Social Media Integration System,” and “Physical Proximity Tracking System.” They ingest validated external data (like sponsor funds) and internal telemetry (like sensor data) to maintain a real-time “World State” of the casino floor. This “World State” is used to adjudicate complex wins, such as determining exactly which five machines are physically adjacent to a winner for a “Splash Pot” payout. By isolating this high-complexity logic in dedicated server components, the system ensures that the “Mystery” mechanics-which involve variable odds, external funding, and spatial tracking—may scale independently of the specific accounting or game outcome systems.

The Progressive Server System 1288 manages the accumulation and distribution of progressive jackpots across a network of gaming machines. This system is central to the operation of progressive games, which offer increasing jackpot amounts that grow with each wager until won. By pooling contributions from multiple machines, the Progressive Server System may offer significantly larger jackpots, enhancing the attractiveness of the games and driving player interest and engagement. The system ensures the accurate and timely update of jackpot amounts displayed to players, maintaining excitement and anticipation. It also guarantees the integrity and fairness of jackpot awards, with robust security measures to prevent tampering and ensure compliance with regulatory standards. The data collected by the Progressive Server System provides casinos with insights into the performance of progressive games, enabling strategic decisions about game placement and promotional activities to maximize player attraction and retention.

The EGM Meter Tracking Component(s) 1289 within the Casino Server System are configured or designed for monitoring and management of data and metrics from electronic gaming machines (EGMs). EGM Meter Tracking Component(s) 1289 may collect a comprehensive range of EGM meter data, including metrics such as coin-in (total amount wagered), coin-out (total winnings paid), total bets placed, and the overall number of games played. Additionally, it tracks MJP-specific metrics, which are integral to understanding the engagement and performance of MJP related features. These may include data on multiplayer interactions, progressive jackpot contributions from each linked game, and usage statistics of unique game features like multi-game and dynamic game allocation. This tracking facilitates precise financial accounting, regulatory compliance, and effective game management by providing insights into player behavior and machine performance, which are important for optimizing the gaming floor layout and enhancing player engagement strategies.

In at least one embodiment, the server system includes at least one network device, and at least one storage device (such as, for example, a direct attached storage device). In one embodiment, server system may be suitable for implementing at least some of the automated money laundering detection and reporting techniques described herein.

In according to one embodiment, network device may include a master central processing unit (CPU), interfaces, and a bus (e.g., a PCI bus). When acting under the control of appropriate software or firmware, the CPU may be responsible for implementing specific functions associated with the functions of a desired network device. For example, when configured as a server, the CPU may be responsible for analyzing packets; encapsulating packets; forwarding packets to appropriate network devices; instantiating various types of virtual machines, virtual interfaces, virtual storage volumes, virtual appliances; etc. The CPU preferably accomplishes at least a portion of these functions under the control of software including an operating system (e.g. Linux), and any appropriate system software (such as, for example, AppLogic™ software).

CPU may include one or more processors such as, for example, one or more processors from the AMD, Motorola, Intel and/or MIPS families of microprocessors. In an alternative embodiment, processor may be specially designed hardware for controlling the operations of server system. In a specific embodiment, a memory (such as non-volatile RAM and/or ROM) also forms part of CPU. However, there may be many different ways in which memory may be coupled to the system. Memory block may be used for a variety of purposes such as, for example, caching and/or storing data, programming instructions, etc.

The interfaces may be typically provided as interface cards (sometimes referred to as “line cards”). Alternatively, one or more of the interfaces may be provided as on-board interface controllers built into the system motherboard. Generally, they control the sending and receiving of data packets over the network and sometimes support other peripherals used with the server system. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G/4G/5G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor to efficiently perform routing computations, network diagnostics, security functions, etc.

In at least one embodiment, some interfaces may be configured or designed to allow the server system to communicate with other network devices associated with various local area network (LANs) and/or wide area networks (WANs). Other interfaces may be configured or designed to allow network device to communicate with one or more direct attached storage device(s).

In at least one embodiment, an architecture having a single processor that handles communications as well as routing computations, etc. may be used. Further, other types of interfaces and media may also be used with the network device.

Regardless of network device's configuration, it may employ one or more memories or memory modules (such as, for example, memory block, which, for example, may include random access memory (RAM)) configured to store data, program instructions for the general-purpose network operations and/or other information relating to the functionality of the various automated money laundering detection and reporting techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

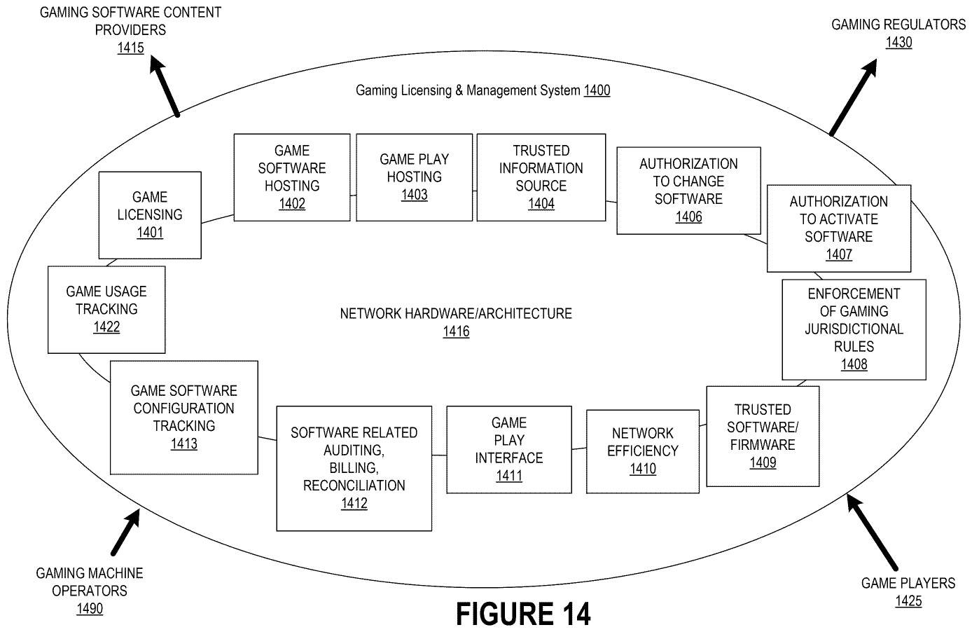

FIG. 14 shows a block diagram illustrating components of a gaming system which may be used for implementing various aspects of example embodiments. In FIG. 14, the components of a gaming system for providing game software licensing and downloads are described functionally. The described functions may be instantiated in hardware, firmware and/or software and executed on a suitable device. In the system, there may be many instances of the same function, such as multiple game play interfaces 1411. Nevertheless, in FIG. 14, only one instance of each function is shown. The functions of the components may be combined. For example, a single device may comprise the game play interface and include trusted memory devices or sources 1409.

The gaming system may receive inputs from different groups/entities and output various services and or information to these groups/entities. For example, game players primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system, receive revenue for the use of their software and compensate the gaming machine operators. The gaming regulators may provide rules and regulations that may be applied to the gaming system and may receive reports and other information confirming that rules are being obeyed.

In the following paragraphs, details of each component and some of the interactions between the components are described with respect to FIG. 14. The game software license host may be a server connected to a number of remote gaming devices that provides licensing services to the remote gaming devices. For example, in other embodiments, the license host may 1) receive token requests for tokens used to activate software executed on the remote gaming devices, 14) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host may track the usage of game software on a plurality of devices in communication with the host. The game usage-tracking host may be in communication with a plurality of game play hosts and gaming machines. From the game play hosts and gaming machines, the game usage tracking host may receive updates of an amount that each game available for play on the devices has been played and on amount that has been wagered per game. This information may be stored in a database and used for billing according to methods described in a utility based licensing agreement.

The game software host may provide game software downloads, such as downloads of game software or game firmware, to various devious in the game system 1400. For example, when the software to generate the game is not available on the game play interface, the game software host may download software to generate a selected game of chance played on the game play interface. Further, the game software host may download new game content to a plurality of gaming machines via a request from a gaming machine operator.

In one embodiment, the game software host may also be a game software configuration-tracking host 1413. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” filed Dec. 12, 2000, which is incorporated herein in its entirety and for all purposes.

A game play host device may be a host server connected to a plurality of remote clients that generates games of chance that are displayed on a plurality of remote game play interfaces 1411. For example, the game play host device may be a server that provides central determination for a bingo game play played on a plurality of connected game play interfaces 1411. As another example, the game play host device may generate games of chance, such as slot games or video card games, for display on a remote client. A game player using the remote client may be able to select from a number of games that are provided on the client by the host device 1403. The game play host device may receive game software management services, such as receiving downloads of new game software, from the game software host and may receive game software licensing services, such as the granting or renewing of software licenses for software executed on the device, from the game license host 1401.

In particular embodiments, the game play interfaces or other gaming devices in the gaming system may be portable devices, such as electronic tokens, cell phones, smart cards, tablet PC's and PDA's. The portable devices may support wireless communications and thus, may be referred to as wireless mobile devices. The network hardware architecture may be enabled to support communications between wireless mobile devices and other gaming devices in gaming system. In one embodiment, the wireless mobile devices may be used to play games of chance.

The gaming system may use a number of trusted information sources. Trusted information sources may be devices, such as servers, that provide information used to authenticate/activate other pieces of information. CRC values used to authenticate software, license tokens used to allow the use of software or product activation codes used to activate software are examples of trusted information that may be provided from a trusted information source 1404. Trusted information sources may be a memory device, such as an EPROM, that includes trusted information used to authenticate other information. For example, a game play interface may store a private encryption key in a trusted memory device that is used in a private key-public key encryption scheme to authenticate information from another gaming device.

When a trusted information source is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in U.S. Pat. No. 6,962,530, by Jackson, filed on Apr. 25, 2002 and titled, “Authentication in a Secure Computerized Gaming System, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information may be designed to detect tampering attempts and clear or erase itself when an attempt at tampering has been detected.

The gaming system of example embodiments may include devices that provide authorization to download software from a first device to a second device and devices that provide activation codes or information that allow downloaded software to be activated. The devices, and, may be remote servers and may also be trusted information sources. One example of a method of providing product activation codes that may be used with example embodiments is describes in previously incorporated U.S. Pat. No. 6,264,561.

A device that monitors a plurality of gaming devices to determine adherence of the devices to gaming jurisdictional rules may be included in the system 1400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network with different types of hardware using different hardware architectures. Game software may be quite large and frequent downloads may place a significant burden on a network, which may slow information transfer speeds on the network. For game-on-demand services that may require frequent downloads of game software in a network, efficient downloading is desirable for the service to viable. Thus, in example embodiments, network efficient devices may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1412. For example, a software licensing billing server may generate a bill for a gaming device operator based upon a usage of games over a time period on the gaming devices owned by the operator. In another example, a software auditing server may provide reports on game software downloads to various gaming devices in the gaming system and current configurations of the game software on these gaming devices.

At particular time intervals, the software auditing server may also request software configurations from a number of gaming devices in the gaming system. The server may then reconcile the software configuration on each gaming device. In one embodiment, the software auditing server may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 14. Many of the interactions are coupled. For example, methods used for game licensing may affect methods used for game downloading and vice versa. For the purposes of explanation, details of a few possible interactions between the components of the system relating to software licensing and software downloads have been described. The descriptions are selected to illustrate particular interactions in the game system 1400. These descriptions are provided for the purposes of explanation only and are not intended to limit the scope of example embodiments described herein.

### Electronic Table Game Terminal (ETGT) Devices and Dealer-Controlled Electronic Table Game (DETG) System(S)

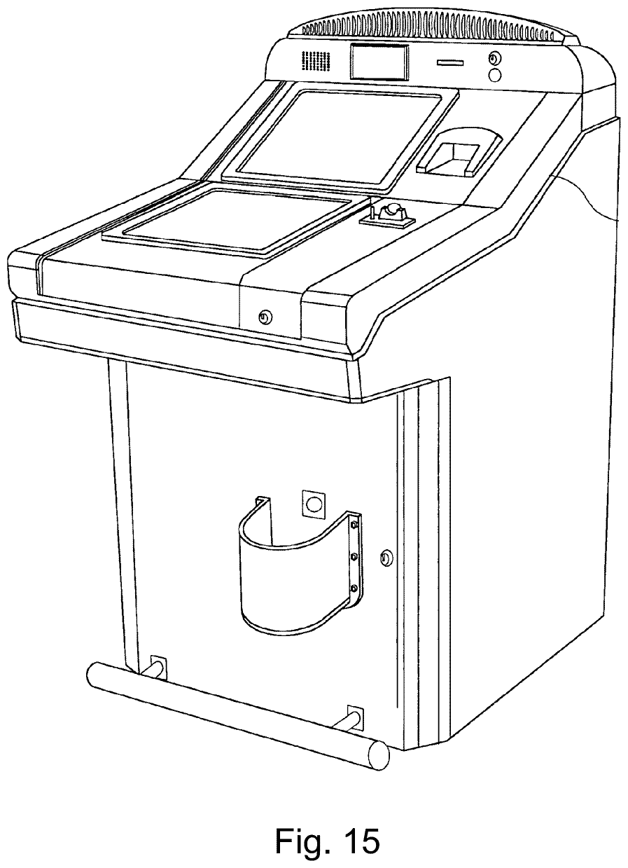

FIG. 15 shows an embodiment of the overall design of a baccarat Dealer-controlled Electronic Table Game (“DETG” or betting terminal).

One aspect of the present invention provides a wager-based table gaming system that allows one to play the live baccarat jackpot described herein. One embodiment of the present invention is shown in FIG. 16. Referring FIG. 16, the baccarat gaming system includes three members: (1) the control unit for automatic shuffle mechanism (CU) (1610), (2) betting computation and tract record central processing unit (BCPU) (1620), and (3) betting terminal for players (BT) (1630) (FIG. 16). The control unit 1610 may further contain control buttons (1612) that allows the dealer to control the shuffling mechanism, which may be manual or automatic, and/or a shuffle master (1614), which may be manual or automatic, for shuffling the cards. The CU 1610 may include any or all of the components which may include control buttons that allow input from dealer and/or capable of (1) receiving the shuffle mechanism input, (2) sending visual output to a screen, and/or (3) sending card results in the player hand and/or bank hand to BCPU 1620. The BCPU 1620 has components or members capable of performing any or all of (1) receiving betting from BT (1630), (2) receiving card results from CU 1610, (3) sending betting results to BT 1630, and/or (4) sending credit to BT 1630.

The betting terminal for players, BT 1630, has components or members capable of performing any or all of (1) sending betting to BCPU 1620, (2) receiving betting results from BCPU 1620, and/or (3) receiving credit from BCPU 1620. Note, the baccarat gaming system may have a number of betting terminals, depending on the need of a gaming establishment. For example, if desirable, the baccarat gaming system may have 1, 2, 3, 4, 5, 6, 7, 8, 9, or 10, up to, e.g., 50 or 250 BTs. CU 1610, BCPU 1620, and BT 1630 may be linked together via a local area network (LAN) (1640) to form a baccarat gaming network between one, two, three or several gaming establishments.

The live baccarat game may have different variations. For example, the game may be played separately as a single live baccarat game. In some embodiments, the individual baccarat games as played in each betting terminal may be linked together. The individual games may all be played in a casino or gaming establishment or in several casino or gaming establishments. The individual games played in different betting terminals may be the same or different. Therefore, some or all of the baccarat games played in individual betting terminals, which may be the same or different baccarat games, may be linked together for a single jackpot.

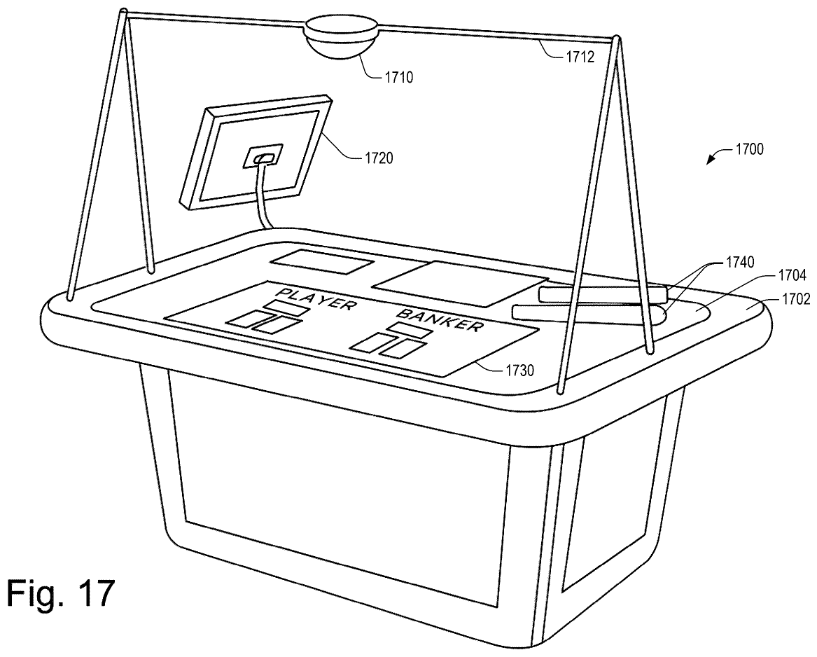

In some embodiments, the gaming system includes a dealing table. An embodiment of the dealing table is shown in FIG. 17, which includes a main body 1700, an overhead video camera 1710 supported by a handle 1712, a signaling mechanism (e.g., a touch screen) 1720 for prompting the dealer of the dealing process, a lighting mechanism 1730 for indication of the order the card dealing process, and rings 1740 marking the space for placing the card shuffle master and box for disposal of played cards. The main body 1700 has an outer rim 1702 and inner rim 1704.

In at least one embodiment, the dealing table has a main body, a touch screen that includes a screen and a pop up mechanism for the touch screen, a lighting mechanism. and rings marking the space for placing the card shuffle master and box for disposal of played cards. The main body has an outer rim and inner rim.

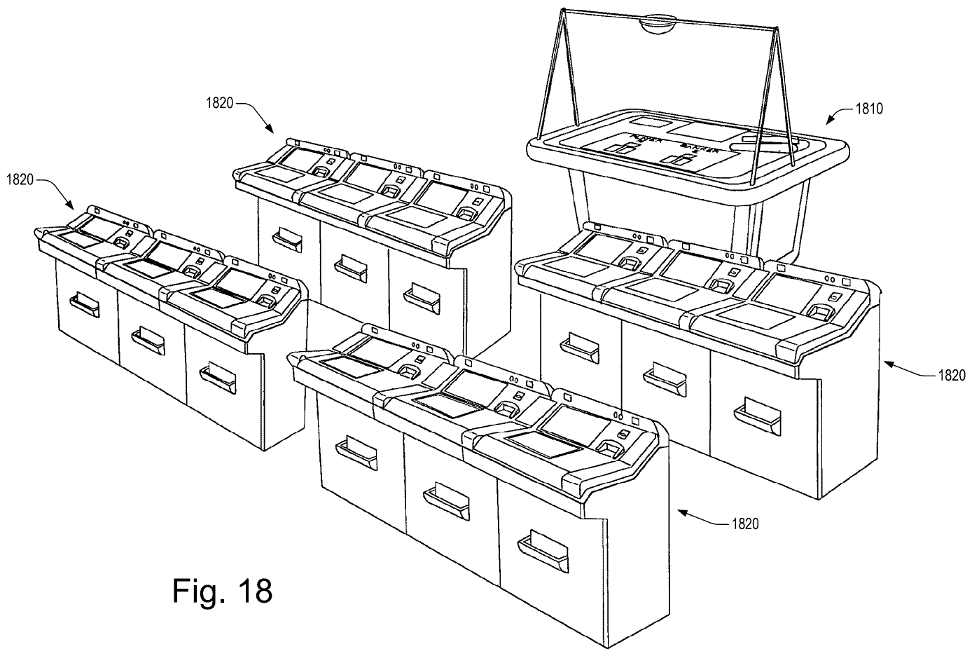

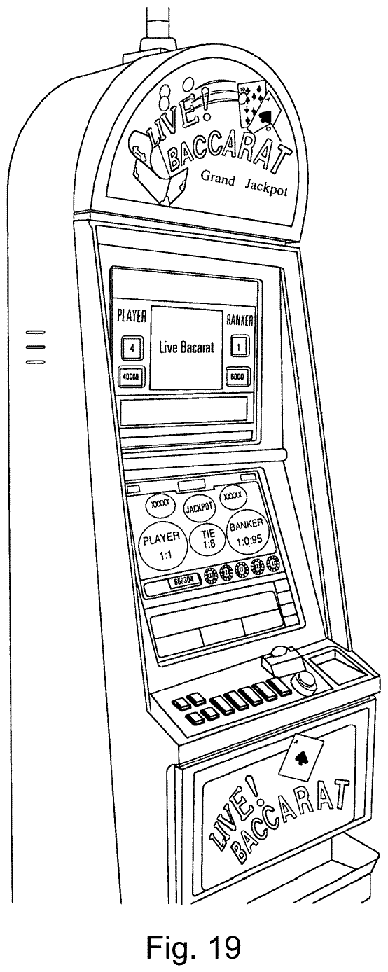

At least one embodiment of the gaming system of the present invention includes a dealing table and a betting terminal. FIG. 18 shows the overall layout of an embodiment of the gaming system of the present invention, which includes a dealing table (“DT”) 1810 and a plurality of betting terminals (“BTs”) 1820. FIG. 19 shows the overall layout of a further embodiment of the gaming system of the present invention.

In some other embodiments, the baccarat jackpot game may be played in an entertainment setting, e.g., in the form of game device such as laptop or desktop computers. In a further embodiment, the baccarat jackpot game may be played in a non-baccarat game, e.g., blackjack, or showhand.

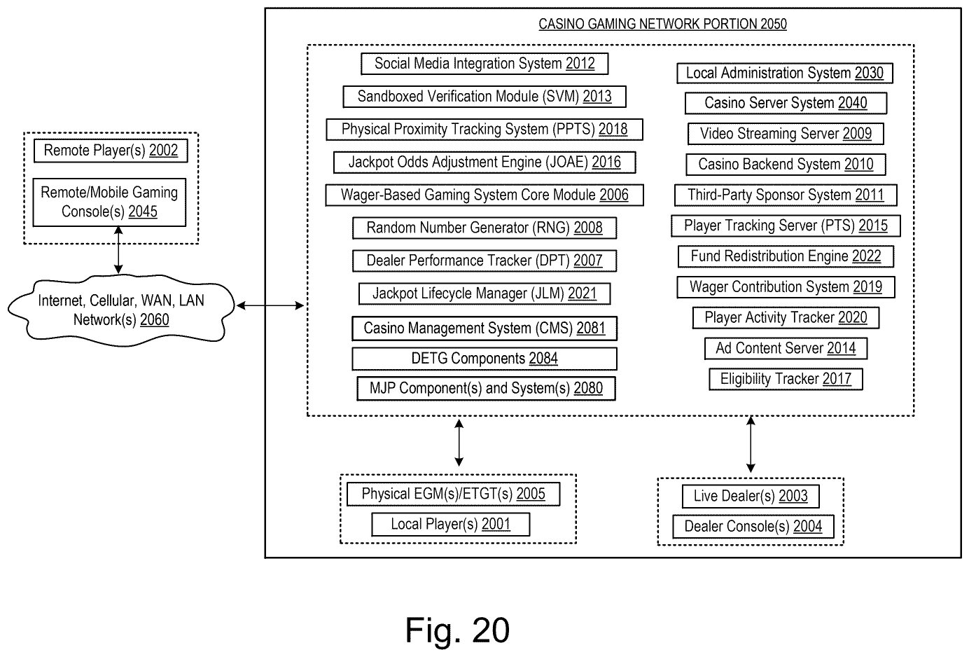

FIG. 20 illustrates an example embodiment of a network architecture and component interaction diagram of a Casino Gaming Network Portion 2050, which illustrates various components of the Wager-Based Gaming and Mystery Jackpot Network Architecture.

As illustrated in the example embodiment of FIG. 20, the Casino Gaming Network Portion 2050 may include a plurality of different types of components, devices, modules, processes, systems, etc., which, for example, may be implemented and/or instantiated via the use of hardware and/or combinations of hardware and software. In at least one embodiment, the Casino Gaming Network Portion 2050 includes various types of systems, components, devices, processes, etc., such as one or more of those described below.

### Local Player(s) (2001)

The Local Player 2001 represents a human participant physically present within the brick-and-mortar casino environment, engaging directly with the wager-based gaming ecosystem through physical interfaces. In this embodiment, the Local Player 2001 is seated at or standing near a Physical EGM/ETGT 2005 or a live gaming table, physically interacting with input devices such as touchscreens, buttons, or lever mechanisms to place wagers. The system identifies the Local Player 2001 through tangible authentication means, such as inserting a magnetic stripe loyalty card, tapping an NFC-enabled device, or undergoing biometric scanning (facial recognition or fingerprint analysis) integrated into the gaming terminal. Functionally, the Local Player 2001 serves as a primary origin point for wagering data and physical proximity inputs, their physical presence is continuously monitored by the Physical Proximity Tracking System (PPTS) 2018 to validate eligibility for location-based Mystery Jackpots. Unlike remote participants, the Local Player 2001 experiences the gaming environment through direct sensory feedback-lights, sounds, and haptic responses from the EGM/ETGT 2005—and interaction with the Live Dealer 2003. The system aggregates the Local Player's wagering history, current session duration, and real-time location data to dynamically calculate their specific contribution to the jackpot pool and their odds of triggering a mystery event. This component is integral to the invention's hybrid nature, as the system must simultaneously synchronize game states for these physical users while accommodating remote participants, ensuring fairness and latency management across both domains. The Local Player 2001 is also the target for “celebration events,” where lighting and sound effects in the physical casino are synchronized to their win, creating a communal atmosphere that cannot be fully replicated remotely.

Illustrative Use Case: Consider a scenario where a Local Player 2001, “Alice,” sits at an Electronic Table Game Terminal (ETGT) playing Baccarat. She inserts her loyalty card, and the system immediately recognizes her tier status. As she plays, the Physical Proximity Tracking System 2018 verifies she is within the “High Limit Zone,” unlocking a specific tier of Mystery Jackpots only available to players in that geographic area. When the Jackpot Odds Adjustment Engine 2016 determines a jackpot is imminent, it triggers a visual alert on Alice's terminal screen and the overhead signage near her. Simultaneously, because Alice has linked her casino account to her social media, the system prompts her to scan a QR code on her physical terminal. Doing so posts a pre-formatted “Feeling Lucky at the Casino!” message to her social feed. The system detects this post via the Social Media Integration System 2012 and instantly applies a multiplier to her jackpot winning probability for the next ten hands, demonstrating the seamless blend of physical presence and digital social interaction.

### Remote Player(s) (2002)

The Remote Player 2002 constitutes a human participant accessing the casino's wager-based gaming services from a location external to the physical casino floor, utilizing a Remote/Mobile Gaming Console 2045. This component connects to the Casino Gaming Network Portion 2050 via the Internet, Cellular, or WAN Network(s) 2060, engaging with the same Live Dealer 2003 and game outcomes as Local Players 2001 but through a digitized video and data stream. The Remote Player 2002 is authenticated via secure multi-factor authentication protocols and is subject to rigorous geolocation verification to ensure compliance with jurisdictional gaming laws. Functionally, the Remote Player 2002 submits wagering commands that are processed by the Wager-Based Gaming System Core Module 2006 with millisecond-level synchronization to match the pace of the live game. A critical aspect of the Remote Player 2002 in this invention is their ability to participate in “Virtual Neighborhoods” or social clusters, despite being physically distant, they can digitally group with other players to pool “luck” or share in community jackpot events. The system provides the Remote Player 2002 with a specialized User Interface (UI) that overlays real-time betting options, jackpot tickers, and sponsored content directly onto the live video feed of the dealer. This component drives the scalability of the invention, allowing a single physical table to service an unlimited number of participants, thereby exponentially increasing the jackpot accumulation rate (chum) compared to a purely physical¹ table. The Remote Player 2002 interactions are sanitized through the Sandboxed Verification Module (SVM) 2013 to prevent any external malicious data from corrupting the secure casino core.

Illustrative Use Case: “Bob,” a Remote Player 2002 located in a different state where online gaming is legal, logs into the casino app on his tablet. He joins the same Live Baccarat table as Alice (the Local Player). The Video Streaming Server 2009 delivers a high-definition, low-latency feed of the dealer to Bob. He notices a “Sponsor Challenge” pop up on his screen: “Share this stream to unlock the Platinum Jackpot Tier.” Bob taps the share button, and the Social Media Integration System 2012 verifies the action. Consequently, the Eligibility Tracker 2017 updates Bob's status from “Standard” to “Platinum Eligible.” Although he is miles away, when the Mystery Jackpot triggers, his screen erupts with digital confetti, and he receives a notification that his share of the community prize has been credited to his digital wallet, illustrating how remote actions directly influence game-state eligibility and rewards in real-time.

### Live Dealer(s) (2003)

The Live Dealer 2003 is the human operator managing the physical gaming table (e.g., Baccarat, Blackjack, Roulette) which serves as the central event generator for both Local and Remote Players. Located within a secure studio or on the casino floor, the Live Dealer 2003 is responsible for the physical manipulation of game elements-dealing cards, spinning wheels, or resolving bets. Crucially, in the context of this invention, the Live Dealer 2003 is equipped with a specialized Dealer Console 2004 that allows them to interact with the digital layer of the Mystery Jackpot system. The Live Dealer 2003 acts as a bridge between the analog and digital worlds; for instance, they may receive prompts on their console to announce a “Sponsor Power Hour” or to manually trigger a jackpot event sequence based on a specific visual cue or system prompt. The system monitors the Live Dealer 2003 via the Dealer Performance Tracker (DPT) 2007, analyzing the speed of dealing and game flow to optimize the pacing of jackpot events. The Live Dealer's actions are digitized via optical recognition and manual input, converting physical outcomes into data packets that the Wager-Based Gaming System Core Module 2006 uses to settle bets. This component is novel in its ability to manually influence or execute the “Mystery” aspect of the jackpot, such as pressing a physical button to “lock in” a prize moment, adding a layer of human suspense and theatricality to the algorithmic RNG process.

Illustrative Use Case: During a lull in the game, the Live Dealer 2003 receives a silent haptic signal from the Dealer Console 2004 indicating that the “Mystery Jackpot” pool has reached a critical overflow threshold. The console displays a prompt: “Initiate Celebration Sequence.” The Live Dealer 2003 then physically presses a large, illuminated button on the console. This manual input sends a signal to the Wager-Based Gaming System Core Module 2006, which instantly changes the lighting in the studio to a gold hue and triggers an animation on the video stream for Remote Players 2002. The Dealer announces, “The Mystery Vault is open!” and proceeds to deal the next hand, which the system has now designated as a “Super Odds” hand. This interaction demonstrates the Live Dealer's role not just as a card distributor, but as an active, synchronized agent in the entertainment and jackpot delivery ecosystem.

### Dealer Console(s) (2004)

The Dealer Console 2004 is a specialized hardware interface located at the physical gaming table, designed exclusively for use by the Live Dealer 2003. It comprises a touchscreen display, physical buttons (including a dedicated Jackpot Trigger mechanism), and secure communication modules linking it to the Casino Backend System 2010. Functionally, the Dealer Console 2004 provides the dealer with critical game state information, such as the number of active remote players, the current status of the Mystery Jackpot pool, and prompts for game pacing. A key feature of the Dealer Console 2004 is its role in the “Man-in-the-Loop” verification process; it may require the dealer to confirm specific outcomes (e.g., “Player Wins”) before the system releases payouts, acting as a secondary validation layer against optical recognition errors. The console also serves as the terminal for the Dealer Performance Tracker 2007, logging timestamps for every hand dealt to analyze efficiency. In the context of the Mystery Jackpot invention, the Dealer Console 2004 is unique because it displays “Sponsorship Scripts” or prompts derived from the Ad Content Server 2014, instructing the dealer to verbally mention a sponsor or product, thereby integrating advertising directly into the gameplay workflow. It operates on a secure, isolated subnet to prevent tampering, ensuring that the dealer's inputs are authenticated and logged immutably.

Illustrative Use Case: The Third-Party Sponsor System 2011 injects a new campaign into the casino network. The Dealer Console 2004 immediately updates its side-panel display with a new script: “Congratulations to the winners! This hand is brought to you by [Sponsor Name].” Simultaneously, the console flashes a “Jackpot Primed” indicator. The dealer sees this private cue and knows that the next round of betting will qualify for the sponsored prize. Upon the conclusion of the hand, the dealer uses the touchscreen on the Dealer Console 2004 to clear the table layout digitally, signaling the Wager-Based Gaming System Core Module 2006 to calculate the payouts and distribute the sponsored “Mystery Prize” to the eligible players. This illustrates the console's function as the command center for blending gameplay, advertising, and jackpot management.

### Physical EGM/ETGT(s) (2005)

The Physical EGM/ETGT (Electronic Gaming Machine/Electronic Table Game Terminal) 2005 is the hardware station used by Local Players 2001. It features high-resolution displays, bill validators, ticket printers, and a complex array of processors designed to render game graphics and process local wagers. Unlike standard slot machines, these ETGTs are networked directly to the Live Dealer 2003's game outcome feed, allowing the terminal to display the live results of a physical table game. A novel aspect of the Physical EGM/ETGT 2005 in this system is its integration with the Social Media Integration System 2012 and Third-Party Sponsor System 2011. The terminal's secondary screens can display dynamic QR codes, “call-to-action” prompts for social sharing, and real-time leaderboards that blend local and remote player statuses. The EGM/ETGT 2005 includes embedded sensors for the Physical Proximity Tracking System 2018 (e.g., Bluetooth beacons or RFID readers) to detect the presence of the player's mobile device or loyalty card even if not inserted. This hardware is the physical enforcement point for eligibility, if the terminal detects the player has walked away (via proximity sensors), it can automatically pause their eligibility for time-based mystery jackpots, ensuring prizes are only awarded to active, present participants.

Illustrative Use Case: A Local Player sits at a Physical ETGT 2005. The main screen displays the live Baccarat trend derived from the Live Dealer's table. The secondary top screen displays a “Community Goal” meter. As the player bets, the ETGT 2005 sends wager data to the Wager Contribution System 2019, causing the meter to rise. When the meter fills, the ETGT 2005 triggers a “Celebration Mode,” locking the terminal into a bonus round. During this mode, the terminal activates its peripheral LED strips to sync with the casino's ambient lighting. Simultaneously, it prints a voucher with a unique code that the player can scan with their phone to claim a digital version of the prize, showcasing the terminal's role as a hybrid physical-digital transaction point.

### Wager-Based Gaming System Core Module (2006)

The Wager-Based Gaming System Core Module 2006 acts as the central processing brain of the entire network. It is a robust, fault-tolerant server cluster responsible for the execution of game logic, bet adjudication, and the maintenance of the “True State” of all gaming activities. It receives inputs from the Dealer Console 2004, Physical ETGTs 2005, and Remote Gaming Consoles 2045, processing thousands of transactions per second. Uniquely, this Core Module 2006 is integrated with the Jackpot Odds Adjustment Engine (JOAE) 2016. It does not merely calculate wins based on card values; it ingests external variables-such as social media engagement scores, dealer speed, and sponsorship triggers—to dynamically alter the payout tables or jackpot probabilities in real-time. It enforces the rules of the specific casino game (e.g., Baccarat Commission) while simultaneously running the “Mystery Jackpot” algorithm as a background process. The Core Module 2006 ensures integrity by cross-referencing the RNG 2008 outputs with the physical card scans from the table, flagging any discrepancies immediately. It is the definitive authority that allows or denies a wager and authorizes the Fund Redistribution Engine 2022 to release funds.

Illustrative Use Case: The Core Module 2006 receives a “Bet Placed” signal from 50 Remote Players and 5 Local Players for a single hand of Blackjack. As the Live Dealer scans the cards, the Core Module 2006 calculates the outcome for each player instantly. Simultaneously, it checks the “Jackpot State” variable managed by the Jackpot Lifecycle Manager 2021. Finding the state is “Active,” the Core Module 2006 runs a secondary algorithm using the RNG 2008 to see if this specific hand triggers the Mystery Prize. It determines that the hand is a trigger event. The Core Module 2006 then instructs the Video Streaming Server 2009 to overlay a “Winner!” graphic on the remote feeds and instructs the Physical ETGTs 2005 to sound their bells, orchestrating a synchronized global win event across disparate platforms.

### Random Number Generator (RNG) (2008)

The Random Number Generator (RNG) 2008 is a computational or hardware device designed to generate a sequence of numbers that lack any pattern, used here specifically for the Mystery Jackpot determination rather than the base card game (which depends on physical cards). In this specific architecture, the RNG 2008 is utilized by the Jackpot Odds Adjustment Engine 2016 to determine when and to whom a mystery prize is awarded. Unlike standard RNGs, this component's parameters (seed values or ranges) can be dynamically adjusted by the Social Media Integration System 2012. for example, a surge in social media activity related to the casino might narrow the RNG range, statistically increasing the frequency of jackpot hits. The RNG 2008 operates under strict regulatory compliance standards, ensuring that while external factors can influence the probability weights, the final selection remains mathematically random and unpredictable. It serves as the impartial arbiter for the “Mystery” component, ensuring that neither the dealer nor the casino can manually force a specific winner, preserving game integrity.

Illustrative Use Case: The Jackpot Odds Adjustment Engine 2016 requests a number from the RNG 2008 every 500 milliseconds to test for a jackpot trigger. The current “Win Threshold” is set to 99.99%. The RNG 2008 generates the value 99.995. This output is sent to the Core Module 2006, which interprets it as a successful trigger. Because the RNG 2008 operates independently of the game logic, this trigger can happen at any moment-before cards are dealt, during the deal, or after-creating the “Mystery” element that keeps players engaged regardless of their hand's actual outcome.

### Video Streaming Server (2009)

The Video Streaming Server 2009 is a high-performance media distribution unit responsible for capturing the high-definition video feed from the Live Dealer 2003 and broadcasting it to Remote Players 2002 with ultra-low latency (typically sub-second). It utilizes adaptive bitrate streaming (H.264/H.265) to accommodate varying client bandwidths. What differentiates this component in the context of the invention is its capability to embed metadata and interactive overlays directly into the video stream via the Ad Content Server 2014. The Video Streaming Server 2009 does not just send pixels; it synchronizes the video frames with data packets from the Wager-Based Gaming System Core Module 2006. This ensures that when a remote player sees a card being dealt on video, the digital representation of that card appears on their UI at the exact same instant. The server also handles the “Augmented Reality” aspects of the Mystery Jackpot, rendering 3D animations (e.g., exploding coins, sponsor logos) over the live video feed when a jackpot is triggered, creating an immersive experience that blends reality with digital rewards.

Illustrative Use Case: A sponsor, “EnergyDrinkCo,” has paid for a “Power Minute.” The Ad Content Server 2014 sends a graphic asset to the Video Streaming Server 2009. The server uses chroma key technology or overlay layers to place the “EnergyDrinkCo” logo virtually on the felt of the Baccarat table in the video feed. Remote players see the logo as if it were printed on the table. Simultaneously, the server embeds a clickable “Claim Sample” hotspot over the logo. When a player taps the video stream on the logo, the server captures the interaction coordinate and relays it to the Ad Content Server 2014 to register the click, demonstrating the server's dual role in broadcasting and interactive advertising.

### Third-Party Sponsor System (2011)

The Third-Party Sponsor System 2011 is an external interface module that allows entities outside the casino (advertisers, luxury brands, partners) to inject value and content into the gaming ecosystem. This is a critical novel element that shifts the jackpot economy from a purely rake-based model to a sponsorship-subsidized model. This system provides an API for sponsors to define “Campaigns” (e.g., “Friday Night giveaways”) and fund specific prize pools managed by the Fund Redistribution Engine 2022. It connects directly to the Ad Content Server 2014 to push media assets and to the Eligibility Tracker 2017 to define custom winning criteria (e.g., “Only players who follow the Brand on Twitter are eligible”). This component enables the “Mystery Jackpot” to act as a marketing vehicle, where the prize might be a physical product (car, watch) provided by the sponsor rather than cash. It allows for the dynamic rebranding of the gaming environment without physical refitting, changing themes and prizes digitally to match the active sponsor.

Illustrative Use Case: A luxury watchmaker wants to promote a new model. They use the Third-Party Sponsor System 2011 to configure a “Golden Hour” campaign. They upload high-res images of the watch and deposit the cash equivalent of the watch into the jackpot fund. The system configures the Jackpot Lifecycle Manager 2021 to trigger this specific prize between 8 PM and 9 PM. During this window, the sponsor system pushes the watch branding to all ETGTs 2005 and Remote Consoles 2045. When a player wins the jackpot, the system notifies them they have won the “Limited Edition Watch,” illustrating how external commercial entities can directly participate in the casino's reward loop.

### Social Media Integration System (2012)

The Social Media Integration System 2012 is a sophisticated gateway that connects the closed loop of the casino network with external social platforms (Facebook, Twitter/X, Instagram). It utilizes APIs to listen for specific hashtags, user mentions, or “shares” related to the casino or the sponsor. Its primary function is to quantify social engagement and convert it into in-game variables. For instance, it can detect if a player has shared a “Victory Post” and signal the Jackpot Odds Adjustment Engine 2016 to temporarily improve that player's odds or reduce the “commission” on their next bet. This system includes a validation engine to prevent fraud (e.g., bot detection). By linking social identity with gaming identity (via the Player Tracking Server 2015), it enables “Social-Proof Wagering,” where the collective activity of a player's friend group can contribute to unlocking community jackpots. This component is pivotal in viral marketing, incentivizing players to broadcast their gaming activity in exchange for tangible gaming advantages.

Illustrative Use Case: The system announces a “Community Pot” that unlocks only when 1,000 tweets with the hashtag #CasinoWin are detected. The Social Media Integration System 2012 continuously polls Twitter for this tag. It maintains a real-time counter displayed on the casino floor screens. As players tweet, the counter rises. Once it hits 1,000, the system sends a “Threshold Met” signal to the Jackpot Lifecycle Manager 2021, which immediately releases the locked funds into the active Mystery Jackpot pool. This creates a direct feedback loop where social buzz translates into financial opportunity for the players.

### Sandboxed Verification Module (SVM) (2013)

The Sandboxed Verification Module (SVM) 2013 is a critical security component designed to protect the integrity of the Casino Gaming Network Portion 2050 while allowing interaction with untrusted external networks (like the Internet and Social Media). It functions as a demilitarized zone (DMZ) proxy. All data entering the casino core from the Social Media Integration System 2012 or Remote/Mobile Gaming Consoles 2045 must pass through the SVM 2013. The SVM inspects data packets for malicious code, SQL injection attempts, or protocol anomalies. It strips strictly necessary data (e.g., “User X shared Post Y”) and regenerates the request internally before passing it to the Wager-Based Gaming System Core Module 2006. This ensures that no direct connection exists between the open internet and the sensitive RNG 2008 or financial engines. The SVM 2013 enables the invention's connectivity features without compromising the regulatory compliance required for gaming licenses.

Illustrative Use Case: A hacker attempts to send a malformed data packet disguised as a “Social Share” confirmation from a mobile device, intending to crash the betting server. The packet arrives at the SVM 2013 first. The SVM analyses the payload and detects an irregular byte sequence that does not match the standard API schema. The SVM 2013 immediately discards the packet and logs the IP address to the Casino Backend System 2010 for blacklisting. The core gaming server never sees the malicious traffic, ensuring the game continues uninterrupted for all other players.

### Jackpot Odds Adjustment Engine (JOAE) (2016)

The Jackpot Odds Adjustment Engine (JOAE) 2016 is an algorithmic processor that dynamically modifies the probability of winning a Mystery Jackpot based on a multivariate set of inputs. Unlike traditional slots with fixed odds, the JOAE 2016 adjusts the “Hit Frequency” or “Win Criteria” in real-time. Inputs include the current “hype meter” from the Social Media Integration System 2012, the volume of wagers from the Wager Contribution System 2019, and configuration directives from the Third-Party Sponsor System 2011. For example, if player activity is low, the JOAE 2016 might automatically increase the odds to generate a win and create excitement. Conversely, if a “High Value” sponsor prize is active, it might adjust the odds to ensure the prize is not won too quickly, maximizing exposure. The JOAE 2016 communicates the current odds state to the RNG 2008 to validate wins. This engine is the mathematical heart of the “Mystery” system, allowing the casino to balance profitability, player excitement, and sponsor requirements dynamically.

Illustrative Use Case: On a Tuesday morning, the casino floor is quiet. The JOAE 2016 detects that the “Wagers Per Minute” metric is below a target threshold. To stimulate play, the JOAE 2016 executes a “Happy Hour” protocol. It communicates with the RNG 2008 to widen the winning number range by 20%, effectively making it easier to trigger a jackpot. Simultaneously, it updates the digital signage to display “Odds Boost Active!” As players start betting more to take advantage of the boost, the JOAE 2016 monitors the increased volume and slowly normalizes the odds back to baseline, effectively managing the floor's energy level.

### Physical Proximity Tracking System (PPTS) (2018)

The Physical Proximity Tracking System (PPTS) 2018 is a hardware-software subsystem responsible for locating Local Players 2001 within the casino with high precision. It utilizes a grid of sensors (Bluetooth Low Energy beacons, WiFi triangulation nodes, and RFID readers) installed in the ceiling, floor, and within the Physical EGM/ETGTs 2005 themselves. The PPTS 2018 tracks the movement of players' mobile devices (via the casino app) or loyalty fobs. Its specific function in this invention is to enable location-based Mystery Jackpots-prizes that can only be won by players in a specific “zone” (e.g., the Baccarat pit) or to award “Splash Prizes” to players physically sitting next to a jackpot winner. The system calculates the distance between devices to verify “Virtual Neighborhoods” formed by physical proximity. This data prevents “remote spoofing” where a remote player might try to claim a location-specific prize, as the PPTS 2018 provides the authoritative physical verification of presence.

Illustrative Use Case: A player triggers a “Splash Jackpot” at Terminal 5. The PPTS 2018 instantly scans the immediate area (radius of 3 meters). It identifies that Terminal 4 and Terminal 6 are occupied by players with active tracking fobs. The PPTS 2018 transmits this ID data to the Fund Redistribution Engine 2022. While the main player at Terminal 5 wins the Grand Prize, the players identified by the PPTS 2018 at Terminals 4 and 6 automatically receive a “Neighbor Bonus” of $50 credited to their machines, incentivizing players to sit together and creating a communal gaming experience.

### MJP Component(s) and System(s) (2080)

The MJP Component(s) and System(s) 2080 constitute the centralized, proprietary hardware and software infrastructure within the Casino Gaming Network Portion 2050, specifically engineered to execute the novel functionalities of the Mystery Jackpot (MJP) ecosystem. Unlike standard legacy components such as the Casino Management System (CMS) 2081, which handle routine accounting and player tracking, the MJP Component(s) and System(s) 2080 act as a specialized overlay network responsible for the sophisticated orchestration of non-standard gaming events. This system serves as the operational nexus that integrates disparate logical modules-including the Jackpot Odds Adjustment Engine (JOAE) 2016, the Physical Proximity Tracking System (PPTS) 2018, and the Sandboxed Verification Module (SVM) 2013—into a cohesive functional unit. Its primary purpose is to bridge the gap between the deterministic, regulated world of wager-based gaming and the dynamic, variable world of external inputs (such as social media actions or third-party sponsorship funding).

Functionally, the MJP Component(s) and System(s) 2080 provide the requisite API endpoints and logic processors to handle high-frequency state changes that occur outside the standard game cycle. For instance, while the Wager-Based Gaming System Core Module 2006 manages the immediate math of a Baccarat hand, the MJP Component(s) and System(s) 2080 simultaneously calculate the “Meta-Game” state, determining if a “Neighbor Luck Share” event or a “Dynamic Odds Boost” should be applied based on real-time telemetry. It acts as the authoritative state manager for “Virtual Neighborhoods,” mapping remote players to physical zones to enable hybrid interaction. Furthermore, this system manages the complex rules of “Open-Loop” funding, securely interfacing with the Third-Party Sponsor System 2011 to convert external capital into internal wagering credits without compromising the integrity of the casino's financial ledger. By isolating these advanced, high-risk features within the dedicated MJP Component(s) and System(s) 2080, the architecture ensures that the core gaming operations remain stable and compliant while enabling a layer of rich, interactive, and commercially integrated gameplay that transforms the passive betting experience into an active, socially connected event.

Illustrative Use Case: Consider a scenario where the casino launches a high-profile “Global Influencer Gala” event using the MJP Component(s) and System(s) 2080. During this event, the system is configured to link physical tables on the casino floor with a massive audience of remote players accessing via mobile apps. A popular streamer (Remote Player 2002) broadcasts their gameplay from a remote console. The MJP Component(s) and System(s) 2080 coordinate with the Social Media Integration System 2012 to track real-time viewer engagement on the stream. When the viewer count surpasses 100,000, the MJP System 2080 triggers a “Viral Velocity” protocol. This protocol sends a command to the Wager-Based Gaming System Core Module 2006 to instantly double the contribution rate of all wagers to the jackpot pool for the next ten minutes. Simultaneously, the MJP System 2080 instructs the Ad Content Server 2014 to push a “Double Jackpot Speed” graphic to every Physical EGM/ETGT 2005 on the floor and every mobile screen. A Local Player 2001, seeing this acceleration, places a maximum bet. The MJP System 2080, utilizing data from the Physical Proximity Tracking System 2018, identifies that this local player is physically seated in the “High Limit Zone” and instructs the Jackpot Odds Adjustment Engine 2016 to apply a favorable probability modifier. When the local player hits the jackpot, the MJP System 2080 orchestrates a synchronized “Splash” celebration, distributing secondary prizes to the remote streamer's followers, thereby proving its ability to unify physical location, digital influence, and wagering logic into a single, verifiable financial event.

### Example Live Dealer-Controlled Electronic Baccarat Table Games

Provided herein are methods and systems therefore for playing a modified live baccarat game. The methods allow the wagering on the live baccarat games according to conventional rules. In addition, the methods provided herein allow betting on a site bet or wager for jackpot with an option for insurance betting. The present invention also provides a jackpot gaming method that allows the banker to make initial contributions for the jackpot game. As used herein, a zero-point card refers to any of the 10, J, Q, or K, and the banker refers to one who owns or operates the live baccarat establishment.

In general, the method for playing live baccarat described herein includes the following steps: dealing cards to a player's hand and a banker's hand according to a set of conventional baccarat rules, allowing at least a first player to place a bet on live baccarat, allowing at least a second player to place a bet on jackpot where the second player may be the same as or different from the first player, determining the outcome of the live baccarat game according to the set of conventional baccarat rules, and determining the outcome of the jackpot according to a combination of cards defined below.

The method described herein also provides an option for insurance betting. As an example, the method includes the following steps: dealing first two cards to a player's hand and two cards to a banker's hand according to a set of conventional baccarat rules, allowing at least a player to place a bet on live baccarat on either the banker's hand to win or the player's hand to win, determining (1) that an insurance bet for the banker's hand is available for the player to place the insurance bet if the sum of the first two cards of the banker's hand is larger than that of a player's hand; and/or (2) that an insurance bet for the player's hand is available for the player to place the insurance bet if the sum of the first two cards of the player's hand is larger than that of a banker's hand, allowing the first player to place (1) the insurance bet for the banker's hand if the first player has betted on the banker's hand to win on live baccarat; or (2) the insurance bet for the player's hand if the first player has betted on the player's hand to win on live baccarat, determining (1) the outcome of the insurance bet for the banker's hand according to a payout ratio for the insurance bet for the banker's hand if the player's hand wins on live baccarat after a third card is dealt on the banker's hand and/or the player's hand; and/or (2) the outcome of the insurance bet for the player's hand according to a payout ratio for the insurance bet for the player's hand if the banker's hand wins on live baccarat after a third card is dealt on the banker's hand, and determining the outcome of the live baccarat game according to the set of conventional baccarat rules.

As another example, the method that provides for an option for insurance betting includes the steps of: dealing first three cards to a player's according to a set of conventional baccarat rules, allowing at least a player to place a bet on live baccarat on either the banker's hand to win or the player's hand to win, determining that an insurance bet for the player's hand is available for the player to place the insurance bet if the sum of the three cards of the player's hand is larger than the sum of the first two cards of the banker's hand, allowing the first player to place the insurance bet for the player's hand if the first player has betted on the player's hand to win on live baccarat, determining the outcome of the insurance bet for the player's hand according to a payout ratio for the insurance bet for the player's hand if the banker's hand wins on live baccarat after a third card is dealt on the banker's hand, and determining the outcome of the live baccarat game according to the set of conventional baccarat rules.

The present invention also provides a software program or a set of software programs for carrying out any or all steps of the betting method described herein. The baccarat game may also be incorporated into an electronic device or an entertainment gaming machine. Representative electronic devices include, but are not limited to, laptop computers or desktop computers.

The object of baccarat is for the bettor to successfully wager on whether the banker's hand or the player's hand is going to win. The bettor receives even money for his wager if he selects the winning hand and loses his wager if he selects the losing hand. Because of the rules of play of baccarat, the banker's hand has a slightly higher chance of winning than does the player's hand. Therefore, if the bettor wagers on the banker's hand, the bettor is required to pay to the gaming establishment a commission (typically 5%) of the amount the bettor wins. No commission is paid if the bettor successfully wagers on the player's hand. The term “wager”, as used herein, may be used interchangeably with the term “bet.” The term “wagering” is used interchangeably with the term “betting.” The term “bettor”, as used herein, is used interchangeably with the term “gambler” or “player”.

Conventional methods of playing baccarat are described as follows: A multiple number of decks of standard playing cards, 52 in number, are used; typically six to twelve decks are shuffled together and placed in a shoe from which the cards are dealt during the play of the game.

Each bettor makes a wager on whether the banker's hand or the player's hand will win. After all wagers are made, two cards are dealt from the shoe to the bank position and two cards are dealt from the shoe to the player's position on the table layout. The cards are turned face up and the value of the banker's hand and the player's hand is determined.

Aces count as one; kings, queens, jacks and tens count as zero and the other cards count as their respective face value. The suits (hearts, diamonds, spades and clubs) have no meaning in baccarat. The highest hand value in baccarat is nine. All hand values range from a low of zero to a high of nine. If when the cards are added together, the total of the hand exceeds nine, then the hand value is determined by subtracting ten from the total of the hand. For example, a seven and nine total sixteen, but the hand value is six. An Ace and a nine total ten, but the hand value is zero.

A two card total of eight or nine is called a “natural”; a two card total of zero is called a “baccarat”. As will be explained hereafter, in certain situations in the play of the game, a third card will be dealt. The value of this third card is added to the total of the first two cards and a new hand value is established. Again, if the new hand total exceeds nine, the hand value is determined by subtracting ten from the total of the hand. Wagering locations are provided on the baccarat table layout. Whichever of the banker's hand or the player's hand is closest to a total of nine is the winner.

The way of betting may differ in different gaming establishments. In the U.S., for example, prior to the deal, each bettor may make one of three wagers: 1) that the banker's hand will win, 2) that the player's hand will win, or 3) that the banker's hand and the player's hand will tie. In Macau, for example, one may make one of five wagers: 1) that the banker's hand will win, ₂) that the player's hand will win, 3) that the banker's hand and the player's hand will tie, 4) that the first two cards in the banker's hand are of the same kind, regardless of the type of suit, forming a Bank Pair, or (5) that the first two cards in the player's hand are of the same kind, regardless of the type of suit, forming a Player Pair.

All winning banker's hand wagers in scenario 1) in both the U.S. and Macau are paid off at odds of one-to-one and the house charges a five percent (5%) commission on the amount won by the bettor. For example, if a bettor wagers $100 on the banker's hand and the banker's hand wins, the bettor wins $100 and is charged a $5 commission on the amount that the bettor won. The bettor is not charged any commission on the amount of his wager.

All wagers that select winning player's hand in scenario 2) in both the U.S. and Macau are paid off at odds of one-to-one and the bettor is not charged any commission on the amount of his winnings or his wager.

All winning wagers on the tie in scenario 3) in both the U.S. and Macau may be paid off at odds of eight-to-one (depending on the gaming establishment) and the bettor is not charged any commission on the amount of his winnings or his wager. If a tie hand occurs, all wagers on the banker's hand and all wagers on the player's hand are “pushes” and the amount wagered is returned to the bettor.

All winning wagers on the Bank Pair bet in scenario 4) in Macau may be paid off at odds of eleven-to-one (depending on the gaming establishment) and the bettor is not charged any commission on the amount of his winnings or his wager.

All winning wagers on the Player Pair bet in scenario 5) in Macau may be paid off at odds of eight-to-one (depending on the gaming establishment) and the bettor is not charged any commission on the amount of his winnings or his wager.

The play of baccarat typically uses three casino dealers to operate the game. The casino dealers jointly participate in the shuffling of the decks of cards. After the shuffle is completed, one of the players is typically asked to cut the decks using a plastic cut card. The dealer then separates and restacks the cards from the point of the cut and the dealer or a player then inserts the plastic cut card no less than fifteen cards (in Las Vegas, U.S.) or no less than twelve cards (in Macau) from the ends of the stacked decks and the entire stacked decks are placed into a shoe from which the cards are dealt during the play of the game. When the inserted plastic cut card appears during play, the hand in progress is completed and that round of play then ends. The cards are reshuffled to prepare for the next round of baccarat.

In conventional baccarat, the bettors deal the cards used in the game. Initially, one of the casino dealers (called the “caller”) passes the shoe to the bettor sitting in seat number “1” at the baccarat table. After all wagers have been made, the caller tells the bettor with the shoe to begin the deal. The bettor deals a first card to the caller, a first card to himself, a second card to the caller and a second card to himself. All cards are dealt face down. The two cards given to the caller represent the player's hand and the two cards kept by the bettor who is dealing the cards represent the banker's hand.

The caller than allows one of the other bettors to turn up the player's hand. Traditionally, this honor is given to the bettor who has made the largest wager. The bettor turns up the two cards of the player's hand and tosses them to the caller. The caller places these two cards face up in the table location designated for the “player's hand” and the caller announces the point total of the player's hand.

The bettor who has the shoe then turns over the cards of the banker's hand and tosses these two cards to the caller.

The caller places these two cards face up in the table location designated for the “banker's hand” and the caller announces to point total of the banker's hand. Depending on the point total of the player's hand and the banker's hand, one more card may be dealt to either the player's hand, the banker's hand, or both, The rules for determining whether a third card is dealt are fixed rules, there is no discretion for either the player's hand or the banker's hand on whether a third card is dealt.

If either the player's hand or the banker's hand has a point total of eight or nine on the first two cards, no third card is dealt to either hand and the hand with the highest point total is the winner (or the hand is a tie, as the case may be). If none of the player's hand or the banker's hand has a point total of eight or nine, then there is a possibility of a third card draw.

The third card draw rules are as follows: Rule #1: If the initial two card player's hand has a point total of 0, 1, 2, 3, 4 or 5, draws a third card. If the initial two card player's hand has a point total of 6 or 7, the player's hand stands and does not receive a third card. Rule #2: If the player's hand stands and does not draw a third card, then the banker's hand follows Rule #1. In other words, if the player's hand has a point total of 6 or 7, the banker's hand draws a third card on a point total of O, 1, 2, 3, 4 or 5 and the banker's hand stands on a point total of 6 or 7. Rule #3: If the player's hand draws a third card, the banker's hand must draw or stand as described in Table 1.

TABLE 1

| Bank hand two | Bank hand draws when the | Bank hand stands when the |
|---|---|---|
| card point total | player's hand third card is: | player's hand third card is: |
| 0, 1 or 2 | Bank always draws | — |
| 3 | 0, 1, 2, 3, 4, 5, 6, 7 or 9 | 8 |
| 4 | 2, 3, 4, 5, 6 or 7 | 0, 1, 8 or 9 |
| 5 | 4, 5, 6 or 7 | 0, 1, 2, 3, 8 or 9 |
| 6 | 6 or 7 | 0, 1, 2, 3, 4, 5, 8 or 9 |
| 7 | — | Bank always stands |

All third card draw determinations are automatically made by the caller who is skilled in the game of baccarat. When the rules of baccarat may require a third card for the player's hand, the caller will request a card for the player's hand. After the player's hand is completed, the banker's hand is completed in the same fashion. The caller then declares which hand has the highest point total and declares that hand the winner (or the caller declares a tie hand as the case may be).

In conventional baccarat the bettor who acts as the dealer continues to deal the cards until the player's hand wins. As soon as the player's hand wins, it is customary to pass the shoe counterclockwise around the baccarat table to the next bettor so that each bettor has the opportunity to deal the cards. Any bettor may decline to deal the cards. The fact that one of the bettors is physically dealing the cards has no affect on the outcome of the game because the rules for drawing and standing do not allow any discretion on the part of the players.

The players may play the game according to conventional baccarat rules, which may vary from place to place. In one embodiment, the baccarat game is played according to the U.S. rules as used in Las Vegas. In another embodiment, the baccarat game is played according to the baccarat rules promulgated by the government of Macau Special Administration Region.

In some embodiments, there is a maximum limit on the total bet may be made through a single betting terminal for the live baccarat game. In one embodiment, the maximum bet may be made through one terminal for live baccarat is, for example, HK$20,000.

The method and system described herein provide a method for jackpot betting, Paradise Jackpot™. The players of the live baccarat game may make a separate bet for jackpot. The jackpot bet may be placed with a bet for live baccarat or without a bet for the same live baccarat.

In some embodiments, the outcome of the jackpot betting is determined by the combination of cards that includes zero-point cards. The combination includes at least one zero-point cards, which are 10, J, Q and K. In one embodiment, the rules for playing Paradise Jackpot™ are described below: (1) The gaming system provides a jackpot. Players who wish to bet on the Paradise Jackpot™ may place a separate bet, e.g. HKD 20 per game in minimum, which will be referred to as bet unit. The maximum number of bet units will not be restricted. (2) Players may bet in Paradise Jackpot™ without placing bet in the same live baccarat game. Each player may place more than one bet unit in one game. When the Paradise Jackpot™ is won, the payout for each bet unit will be equal to the money in the Paradise Jackpot™ pool divided by the total number of bet unit. (3) If the first 5 cards drawn in one baccarat game resulting in A, K, Q, J, 10 in spade, regardless of the sequence, then 100% of the Paradise Jackpot™ is won. (4) If the first 5 cards drawn in one baccarat game resulting in K, Q, J, 10 in spade and A in either heart, club or diamond, regardless of the sequence, then 10% of the Paradise Jackpot™ is won.

In some other embodiments, the Paradise Jackpot™ may be played according to Rules (1)-(111), defined below: (I) The Paradise Jackpot™ is won if any of the following is met: 1) any five cards forming a sequence, regardless of the order they are drawn, e.g., A, 2, 3, 4, 5 or 9, 10, J, Q, K; 2) five cards of a kind, e.g. A, A, A, A, A or K, K, K, K, K; 3) four cards of a kind, regardless of the order they are drawn, e.g., K, K, K, K, 2 or 2, K, K, K, K; 4) three cards of a kind plus a pair, regardless of the order they are drawn, e.g., 10, 10, 10, 2, 2; 5) three cards of a kind, regardless of the order they are drawn, e.g., 2, 2, 2, 10, J; 6) two pairs, regardless of the order they are drawn, e.g., Q, Q, 2, K, K; 7) all the 5 cards of the same symbols (same suit): spade, heart, club or diamond, e.g., A (spade), 10 (spade), J (spade), K (spade), Q (spade); or 8) any specific combination of five cards as specified from time to time. (II). The Paradise Jackpot™ is won by any specific combination of the first four, three or two cards drawn in a live baccarat game, with regard to/regardless of the drawn sequence. Specifically, the Paradise Jackpot™ is won if any of the following is met: (A) if the first four cards that are drawn form a combination as defined below: 1) the first four cards forming a sequence, with regard to/regardless of the order they are drawn, e.g., A, 2, 3, 4, or 10, J, Q, K; 2) the first four cards of a kind, e.g. A, A, A, A or J, J, J, J; 3) three cards of a kind, with regard to/regardless of the order they are drawn, e.g., K, K, K, 2 or 10, 10, 10, 2; 4) two cards of a kind plus a pair, with regard to/regardless of the order they are drawn, e.g., 2, 2, J, J, which is a two pair sequence; 5) two cards of a kind, with regard to/regardless of the order they are drawn, e.g., 10, 10, Q, Q; 6) all the four cards of the same symbols (same suit): spade, heart, club or diamond, e.g., A (spade), 10 (spade), J (spade), K (spade); or 7) any specific combination of the first four cards as specified from time to time, (B) if the first three cards that are drawn form a combination as defined below: 1) the first three cards forming a sequence, with regard to/regardless of the order they are drawn, e.g., A, 2, 3, or 10, J, K; 2) the first three cards of a kind, e.g. A, A, A or 2, 2, 2; 3) two cards of a kind, with regard to/regardless of the order they are drawn, e.g., K, K, 2 or 10, 10, 2; 4) two cards forming a pair, with regard to/regardless of the order they are drawn, e.g., 2, J, J or J, J, 2; 5) all the three cards of the same symbols (same suit): spade, heart, club or diamond, e.g., A (spade), J (spade), K (spade); or 6) any other specific combination of the first four cards as specified from time to time, or (C) if the first two cards that are drawn form a combination as defined below: 1) the first two cards forming a sequence, with regard to/regardless of the order they are drawn, e.g., A, 2, or J, Q; 2) the first two cards of a kind, e.g. A, A or 10, 10, which is also a pair; 3) the first two cards of the same symbols (same suit): spade, heart, club or diamond, e.g., A (spade), 1 O (spade); or 4) any other specific combination of the first four cards as specified from time to time.

(III) The Paradise Jackpot™ is won by any specific combination of the last six, five, four, three, and two cards drawn in a live baccarat game, with regard to/regardless of the drawn sequence. Specifically, the Paradise Jackpot™ is won if any of the following is met: (A) if the last six cards that are drawn form a combination as defined below: 1) the last six cards forming a sequence, with regard to/regardless of the drawn sequence they are drawn, e.g., A, 2, 3, 4, 5, 6 or 8, 9, 10, J, Q, K; 2) six cards of a kind, e.g. A, A, A, A, A, A or 2, 2, 2, 2, 2, 2; 3) five cards of a kind, with regard to/regardless of the order they are drawn, e.g., K, K, K, K, K, 2 or 2, 10, 10, 10, 10, 10; 4) four cards of a kind, with regard to/regardless of the order they are drawn, e.g., K, K, K, K, 2, 10 or 2, A, J, J, J, J; 5) four cards of a kind plus a pair, with regard to/regardless of the order they are drawn, e.g., K, K, K, K, 2, 2 or 2, 2, J, J, J, J; 6) three cards of a kind plus a pair, with regard to/regardless of the order they are drawn, e.g., 2, 2, 2, J, J, A or J, J, 2, 2, 2, K; 7) three cards of a kind, with regard to/regardless of the order they are drawn, e.g., A, A, A, 10, J, K or 10, J, K, 2, 2, 2; 8) three pairs, with regard to/regardless of the order they are drawn, e.g., Q, Q, K, K, J, J or 2, 2, 10, 10, K, K; 9) all the six cards of the same symbols (same suit): spade, heart, club or diamond, e.g., A (spade), 10 (spade), J (spade), K (spade), Q (spade), 2 (spade); or 10) any other specific combination of six cards as specified from time to time.

(B) if the last five cards that are drawn form a combination as defined below: 1) the last five cards forming a sequence, with regard to/regardless of the order they are drawn, e.g., A, 2, 3, 4, 5 or 9, 10, J, Q, K; 2) five cards of a kind, e.g. A, A, A, A, A or 2, 2, 2, 2, 2; 3) four cards of a kind, with regard to/regardless of the order they are drawn, e.g., K, K, K, K, 2 or 2, 10, 10, 10, 10; 4) three cards of a kind plus a pair, regardless of the order they are drawn, e.g., 2, 2, 2, J, J; 5) three cards of a kind, regardless of the order they are drawn, e.g., 2, 2, 2, 10, Q; 6) two pairs, regardless of the order they are drawn, e.g., Q, Q, A, 10, 10; 7) all the 5 cards of the same symbols (same suit): spade, heart, club or diamond; e.g., A (spade), 10 (spade), J (spade), K (spade), Q (spade); or 8) any other specific combination of five cards as specified from time to time, (C) if the last four cards that are drawn form a combination as defined below: 1) the last four cards forming a sequence, with regard to/regardless of the order they are drawn, e.g., A, 2, 3, 4, or 10, J, Q, K; 2) the last four cards of a kind, e.g. A, A, A, A or 10, 10, 10, 10; 3) three cards of a kind, with regard to/regardless of the order they are drawn, e.g., K, K, K, 2 or 10, 10, 10, 2; 4) two cards of a kind plus a pair, regardless of the order they are drawn, e.g., A, A, J, J, which is a two pair sequence; 5) two cards of a kind, regardless of the order they are drawn, e.g., 2, 2, Q, Q; 6) all the four cards of the same symbols (same suit): spade, heart, club or diamond, e.g., A (spade), 10 (spade), K (spade), Q (spade); or 7) any other specific combination of the first four cards as specified from time to time, (D) if the last three cards that are drawn form a combination as defined below: 1) the last three cards forming a sequence, with regard to/regardless of the order they are drawn, e.g., A, 2, 3, or J, Q, K; 2) the last three cards of a kind, e.g. A, A, A or Q, Q, Q; 3) two cards of a kind, with regard to/regardless of the order they are drawn, e.g., K, K, 2 or 10, 10, 2; 4) two cards forming a pair, with regard to/regardless of the order they are drawn, e.g., 2, J, J or J, J, 2; 5) all the last three cards of the same symbols (same suit): spade, heart, club or diamond, e.g., A (spade), J (spade), K (spade); or 6) any other specific combination of the first four cards as specified from time to time, (E) if the last two cards that are drawn form a combination as defined below: 1) the last two cards forming a sequence, with regard to/regardless of the order they are drawn, e.g., A, 2, or 10, J; 2) the last two cards of a kind, e.g. A, A or 2, 2, which is also a pair; 3) the last two cards of the same symbols (same suit): spade, heart, club or diamond, e.g., A (spade), 10 (spade); or 4) any other specific combination of the first four cards as specified from time to time.

In some embodiments, the method and system described herein provided for options for insurance bet for Banker's hand and/or Player's hand. For example, in some embodiments, the insurance options may be available after the first 2 cards have been distributed to each of the Banker's hand and the Player's hand, respectively. In some embodiments, the rules for insurance option for Banker's hand are as follows: An insurance bet for Banker's hand may be only available to the gambler who has already betted on the Banker's hand to win in the same baccarat game. If the sum of the first two cards of Banker's hand is larger than that of Player's hand, the insurance betting option button for Banker's hand will flash on the screen (e.g., flashing for 15 seconds), indicating the insurance betting option for Banker's hand is available for players to put the insurance bets according to the insurance betting rules. The insurance betting option button for Banker's hand will flash on the screen with a payout ratio, which may be, for example, one according to the table below (Table 2) for betting on the winning of Player's hand after a third card is/are dealt on either/both hand(s).

TABLE 2

| Sum of first | Sum of first | Payout ratio if the Player |
|---|---|---|
| 2 cards of | 2 cards of | wins after a third card is/ |
| Banker's hand | Player's hand | are dealt on either/both hand(s) |
| 4 | 0 to 3 | 1.5x |
| 5 | 0 to 4 | 2x |
| 5 | 5 | 1x |
| 6 | 0 to 5 | 3x |
| 7 | 0 to 5 | 4.5x |

In some embodiments, the rules for insurance option for Player's hand are as follows: An insurance bet for Player's hand may be only available to the gambler who has already betted on Player's hand to win in the same baccarat game. If the sum of the first two cards of Player's hand is larger than that of Banker's hand, the insurance betting option button for Player's hand will flash on the screen (for example, flashing for 15 seconds), indicating the insurance betting option for Player's hand is available for players to put the insurance bets according to the insurance betting rules. The insurance betting option button for Player's hand will flash on the screen with a payout ratio, which may be, for example, one according to the table below (Table 3) for betting on the winning of Banker's hand after a third card is dealt on Banker's hand:

TABLE 3

| Sum of first | Sum of first | Payout ratio if the Banker |
|---|---|---|
| 2 cards of | 2 cards of | wins after a third card is |
| Player's hand | Banker's hand | dealt on the Banker's hand |
| 6 | 0 to 5 | 3x |
| 7 | 0 to 5 | 4.5x |

In some embodiments, an insurance bet for Player's hand may be available after the first 3 cards have been distributed to Player. This insurance bet may be only available to the gambler who has already betted on Player's hand to win in the same baccarat game. If the sum of the three cards of Player's hand is larger than the sum of the first two cards of Banker's hand, the insurance betting option button for Player's hand will flash on the screen (e.g., flashing for 15 seconds), indicating the insurance betting option for Player's hand is available for players to put the insurance bets according to the insurance betting rules. The insurance betting option button for Player's hand will flash on the screen with a payout ratio, which may be, for example, one according to the table below (Table 4) for betting on the winning of Banker's hand after a third card is dealt on Banker's hand:

TABLE 4

| Sum of first | Sum of first | Payout ratio if the Banker |
|---|---|---|
| 3 cards of | 2 cards of | wins after a third card is |
| Player's hand | Banker's hand | dealt on the Banker's hand |
| 4 | 0 to 3 | 1x |
| 5 | 0 to 4 | 2x |
| 8 | 0 to 5 | 9x |
| 9 | 0 to 5 | 11x |

In some embodiments, the embodiments of the insurance betting described above and the various embodiments of jackpot described previously may be combined.

The combinations of cards not defined above may be readily derived from time to time with or without the assistance of a computer following established rules of forming combinations of a set of defined members. The amount of Paradise Jackpot™ award may be determined by and distributed according to, e. g., the probability of a combination of cards as defined above or otherwise specified from time to time.

There may be more than one live baccarat game going on simultaneously in different casinos in Macau. In some embodiments, all Paradise Jackpot™ bets from different live baccarat tables will contribute to one grand Paradise Jackpot™ pool. If the Paradise Jackpot™ is won in anyone live baccarat table, all players who place Paradise Jackpot™ bets, regardless of the live baccarat table they bet, will share the grand Paradise Jackpot™ pool according to the bet units that each player placed in the jackpot betting.

Paradise Jackpot™ may be played with bets from players as the sole source of the jackpot pool or with bets and an initial contribution from the banker. The term “banker” generally refers to the owner of a gaming establishment operating the live baccarat defined herein or one who operates the live baccarat game. In one embodiment, the banker contributes a sum of money as the initial Paradise Jackpot™ (e.g., HKD 50,000). A certain percentage, e.g., 55%, of the Paradise Jackpot™ bets from the players will be contributed towards the Paradise Jackpot™ pool, a certain percentage (e.g., 40%) of the bets will be collected by the banker as profit, and the remaining portion (e.g., 5%) of the bets will be accumulated as the seed for the next game.

### Application to Various Wager-Based Gaming Environments

In at least some other embodiments (not illustrated), the Electronic Gaming Machine(s) (EGMs), Electronic Gaming Terminal(s) (EGTs), Electronic Table Game Terminal(s) (ETGT), and Dealer-controlled Electronic Table Game (DETG) system(s) of the present invention may be configured or designed to host wager-based gameplay relating to various other types of wager-based casino table games. While many examples provided herein relate to Baccarat, the fundamental architecture of the modular widget interface and data intelligence framework is game-agnostic and may be readily adapted. The system's power lies in this inherent flexibility, allowing operators to deploy a consistent, yet highly specialized, user experience across their entire gaming floor. Such other popular casino wager-based table games may include, for example, blackjack, sic bo, poker, craps, roulette, pai gow poker, three card poker, Caribbean stud poker, casino war, Texas hold'em, etc.

The modular nature of the CoralDesk™ system, which allows for the dynamic selection and arrangement of multiple mini-applications, is particularly well-suited for this adaptability. The various different embodiments of the widget applications and AI-assisted analytic GUIs described herein may be specifically configured or designed for use with one or more particular types of wager-based casino table games. The system's ability to bind a live game data feed-containing game-specific events, outcomes, and player actions—to each widget and process that data through the AI Insight Module enables the creation of highly specialized analytical tools for any game with a structured stream of event data. This allows for the development of “game packs,” where a new set of tailored widgets and AI models may be deployed to the system for a new game type without altering the specific software.

For example, in an embodiment configured for a blackjack table game, the widgets may be specialized to provide insights relevant to blackjack strategy and outcomes. A “Basic Strategy Assist” widget may receive data on the player's current card total and the dealer's visible up-card. In response, it may display a graphical highlight, such as a subtle glowing border, around the mathematically optimal action on the betting interface (Hit, Stand, Double Down, Split), guiding less experienced players. An AI-powered “Shoe Composition” widget may analyze the history of cards dealt from the shoe, transforming this raw data into a simplified, real-time classification of the shoe's state (e.g., a visual gauge moving from “Cold” to “Hot”). This provides players with a simplified, actionable insight for bet sizing strategies without requiring them to learn complex card counting systems. Furthermore, a “Side Bet Interval Map,” similar to the one described for Baccarat, may track the frequency and distribution of outcomes for popular blackjack side bets like “21+3” or “Perfect Pairs,” helping players identify when these side bets may be statistically overdue.

In another example, for an embodiment configured for a craps table game, the widget framework may be adapted to help players navigate the game's notorious complexity and track its dynamic state. A “Dice Roll History” widget may provide a heat map or frequency chart of the last 50 dice roll outcomes, visually highlighting “hot” or “cold” numbers and comparing their frequency to the statistical probability. An “AI Trend Alarm” widget may be specifically configured to analyze roll sequences for statistically significant patterns, such as an unusually long duration without a “seven-out,” and provide a real-time alert for a potential “hot shooter.” Additionally, a “Player Bet Dashboard” widget would solve a major usability problem by receiving data about a player's multiple active bets (e.g., Pass Line with odds, Come bets, Place bets). It would then display a clear, consolidated graphical summary of the total amount at risk and the specific potential payout for each possible dice outcome on the next roll, dramatically simplifying the complex betting landscape for novice and expert players alike.

In yet another example, for an embodiment configured for a roulette table game, the widgets may be designed to provide deep statistical analysis of wheel spin outcomes. A “Smart Scoreboard” widget may display not only the sequence of the last 20 winning numbers but also dynamically updated statistical charts showing the real-time frequency of Red/Black, Odd/Even, and High/Low outcomes, flagging any statistically significant deviations from the norm. A “Wheel Zone Tracker” widget may provide a graphical representation of the physical roulette wheel and use the history of winning numbers to highlight which sections of the wheel (e.g., Voisins du Zéro, Tiers du Cylindre, Orphelins) have been most active, a feature invaluable for players employing section-based betting strategies. The AI Insight Module may be configured to analyze the long-term distribution of winning numbers to identify statistically significant biases, providing an alert to the player when a particular dozen or column shows a non-random frequency of hits over a large sample of spins. A “Neighbor Bet Assist” widget may further enhance usability, allowing a player to select a number on the betting layout and having the widget automatically highlight the corresponding adjacent numbers on the wheel for quick and easy betting.

### MJP Flow Procedures

### Example Procedures and Flow Diagrams

The Figures illustrate various example embodiments of different procedures and/or procedural flows which may be used for facilitating activities relating to one or more of the MJP aspects disclosed herein.

According to different embodiments, at least a portion of the various types of functions, operations, actions, and/or other features provided by the MJP Procedures of the Figures may be implemented at one or more client systems(s), at one or more System Servers (s), and/or combinations thereof.

In at least one embodiment, one or more of the MJP procedures may be operable to utilize and/or generate various different types of data and/or other types of information when performing specific tasks and/or operations. This may include, for example, input data/information and/or output data/information. For example, in at least one embodiment, the MJP procedures may be operable to access, process, and/or otherwise utilize information from one or more different types of sources, such as, for example, one or more local and/or remote memories, devices and/or systems.

Additionally, in at least one embodiment, the MJP procedures may be operable to generate one or more different types of output data/information, which, for example, may be stored in memory of one or more local and/or remote devices and/or systems. Examples of different types of input data/information and/or output data/information which may be accessed and/or utilized by the MJP procedures may include, but are not limited to, one or more of those described and/or referenced herein.

In at least one embodiment, a given instance of the MJP procedures may access and/or utilize information from one or more associated databases. In at least one embodiment, at least a portion of the database information may be accessed via communication with one or more local and/or remote memory devices. Examples of different types of data which may be accessed by the MJP procedures may include, but are not limited to, one or more of those described and/or referenced herein.

According to specific embodiments, multiple instances or threads of the MJP procedures may be concurrently implemented and/or initiated via the use of one or more processors and/or other combinations of hardware and/or hardware and software. For example, in at least some embodiments, various aspects, features, and/or functionalities of the MJP procedures may be performed, implemented and/or initiated by one or more of the various systems, components, systems, devices, procedures, processes, etc., described and/or referenced herein.

According to different embodiments, one or more different threads or instances of the MJP procedures may be initiated in response to detection of one or more conditions or events satisfying one or more different types of minimum threshold criteria for triggering initiation of at least one instance of the MJP procedures. Various examples of conditions or events which may trigger initiation and/or implementation of one or more different threads or instances of the MJP procedures may include, but are not limited to, one or more of those described and/or referenced herein.

According to different embodiments, one or more different threads or instances of the MJP procedures may be initiated and/or implemented manually, automatically, statically, dynamically, concurrently, and/or combinations thereof. Additionally, different instances and/or embodiments of the MJP procedures may be initiated at one or more different time intervals (e.g., during a specific time interval, at regular periodic intervals, at irregular periodic intervals, upon demand, etc.).

In at least one embodiment, initial configuration of a given instance of the MJP procedures may be performed using one or more different types of initialization parameters. In at least one embodiment, at least a portion of the initialization parameters may be accessed via communication with one or more local and/or remote memory devices.

In at least one embodiment, at least a portion of the initialization parameters provided to an instance of the MJP procedures may correspond to and/or may be derived from the input data/information.

It will be appreciated that the procedural diagrams of the Figures are merely specific examples of procedural flows and/or other activities which may be implemented to achieve one or more aspects of the MJP techniques described herein. Other embodiments of procedural flows (not shown) may include additional, fewer and/or different steps, actions, and/or operations than those illustrated in the example procedural diagrams of the Figures.

This application incorporates by reference in its entirety and for all purposes U.S. Pat. No. 8,182,321, titled “Methods and Systems for Playing Baccarat Jackpot,” by Chun et al., issued May 22, 2012.

This application incorporates by reference in its entirety and for all purposes U.S. Pat. No. 8,956,210, titled “Methods and Systems for Playing Baccarat Jackpot,” by Chun et al., issued Feb. 17, 2015.

This application incorporates by reference in its entirety and for all purposes U.S. Pat. No. 10,198,893, titled “Methods and Systems for Playing Baccarat Jackpot,” by Chun et al., issued Feb. 5, 2019.

This application incorporates by reference in its entirety and for all purposes U.S. Pat. No. 10,702,763, titled “Methods and Systems for Playing Baccarat Jackpot,” by Chun et al., issued Jul. 7, 2020.

This application incorporates by reference in its entirety and for all purposes U.S. Pat. No. 7,922,587, titled “Betting Terminal and System,” by Chun et al., issued Apr. 12, 2011.

This application incorporates by reference in its entirety and for all purposes U.S. Pat. No. 7,918,723, titled “Methods and Systems for Playing Baccarat Jackpot,” by Chun et al., issued Apr. 5, 2011.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A system for managing synchronized mystery progressive jackpots in a live dealer-controlled gaming environment, the system comprising:
a central gaming network;
a plurality of electronic table game terminals connected to the central gaming network, each electronic table game terminal being operable for receiving a player wager on a base game;
a dealer console physically situated proximate to a live dealer and communicatively coupled to the central gaming network, the dealer console comprising a biometric authentication scanner and a trusted platform module;
a first server system comprising a processor and a dealer performance tracker module;
a non-transitory memory storing a progressive jackpot pool;
the first server system being operable for:
continuously monitoring game outcomes to update a dealer performance metric of the live dealer via the dealer performance tracker module;
electronically enabling a physical trigger mechanism on the dealer console only when the dealer performance metric meets a predefined threshold condition;
receiving a cryptographically signed manual trigger signal from the dealer console, wherein the cryptographically signed manual trigger signal comprises a biometric hash of the live dealer verified by the trusted platform module; and
in response to receiving the cryptographically signed manual trigger signal, executing a multi-game state synchronization protocol by: (i) broadcasting a lock-state command to the plurality of electronic table game terminals; (ii) suspending independent game cycles on the plurality of electronic table game terminals upon completion of a current active hand; (iii) receiving a ready-state acknowledgement from the plurality of electronic table game terminals; and (iv) upon receiving the ready-state acknowledgement, executing a random number generator (RNG) evaluation to determine a mystery jackpot outcome and transmitting a synchronized execution command to the plurality of electronic table game terminals to display the mystery jackpot outcome simultaneously.

2. The system of claim 1, wherein the dealer console comprises a bonus activation interface, and wherein the cryptographically signed manual trigger signal is initiated by the live dealer pressing a button on the bonus activation interface.

3. The system of claim 2, wherein the first server system is further operable for temporarily enhancing a contribution rate of player wagers to the progressive jackpot pool for a limited time period following the initiating of the cryptographically signed manual trigger signal.

4. The system of claim 1, wherein the mystery jackpot outcome comprises the first server system applying a temporary win multiplier to the progressive jackpot pool for a defined number of subsequent game rounds.

5. The system of claim 1, wherein the plurality of electronic table game terminals are configured for playing a plurality of different game types, and wherein the first server system performs the step of transmitting the lock-state command simultaneously to the plurality of electronic table game terminals running disparate game types.

6. The system of claim 1, wherein the cryptographically signed manual trigger signal initiates a jackpot bonus round, and wherein the first server system is further operable for temporarily altering betting parameters for the jackpot bonus round.

7. The system of claim 1, wherein the dealer console is a live dealer control panel, and wherein the first server system receives the cryptographically signed manual trigger signal from the live dealer control panel.

8. A system for managing externally funded progressive jackpots in a secure networked gaming environment, the system comprising:
a secure internal casino gaming network;
a plurality of electronic table game terminals connected to the secure internal casino gaming network;
a sandboxed verification module located within a demilitarized zone of the secure networked gaming environment, the sandboxed verification module being configured to interface with an external third-party sponsor system;
a first server system comprising a processor located within the secure internal casino gaming network, the first server system being connected to the sandboxed verification module via a unidirectional message bus;
a non-transitory memory storing a shadow ledger associated with a progressive jackpot pool;
wherein the sandboxed verification module is operable for: (i) receiving an external data payload from the external third-party sponsor system containing funding parameters; (ii) performing a deep packet inspection and schema validation on the external data payload; (iii) sanitizing the external data payload by stripping executable code and metadata to create a sanitized internal payload; (iv) translating the sanitized internal payload into an internal binary protocol message; and (v) pushing the internal binary protocol message to the unidirectional message bus;
wherein the first server system is operable for:
consuming the internal binary protocol message from the unidirectional message bus;
updating the shadow ledger associated with the progressive jackpot pool to reflect the funding parameters without commingling the external data payload with internal game logic; and
transmitting a command to the plurality of electronic table game terminals to display promotional graphics associated with the external third-party sponsor system only upon successful validation of the funding parameters.

9. The system of claim 8, wherein the processor of the first server system is further operable for verifying a social media action of a player using an external social media platform, wherein the social media action is a non-wagering activity.

10. The system of claim 9, wherein the first server system is further operable for, upon successful verification of the social media action, dynamically adjusting a set of eligibility criteria for the player regarding the progressive jackpot pool.

11. The system of claim 10, wherein the step of dynamically adjusting comprises the first server system increasing a set of odds of the player being selected as a jackpot winner.

12. The system of claim 8, wherein the funding parameters are received in exchange for displaying sponsor branding on a dynamic user interface of one of the plurality of electronic table game terminals during a jackpot growth phase.

13. The system of claim 9, wherein the first server system is further operable for applying a wagering credit to a player account associated with the player in exchange for the player completing a referral via the external social media platform.

14. The system of claim 8, wherein the first server system is further operable for determining a mystery trigger independent of a base game outcome.

15. The system of claim 8, wherein the promotional graphics are displayed on the plurality of electronic table game terminals only when the progressive jackpot pool exceeds a predetermined threshold.

16. The system of claim 8, wherein the external third-party sponsor system is a non-casino brand.

17. A system for managing personalized mystery progressive jackpots using real-time probability modification, the system comprising:
a plurality of electronic table game terminals, each electronic table game terminal being operable for a player participating in a wagering game;
a player tracking server storing a VIP status for the player;
a jackpot odds adjustment engine comprising a high-frequency stream processing application;
a first server system comprising a processor and an eligibility tracker, the first server system being operable for:
receiving player identity data and corresponding VIP status for the player from the player tracking server in real-time;
tracking a plurality of real-time player activity metrics for the player, including wager velocity, session duration, and theoretical loss;
constructing a state vector representing a current session profile of the player;
inputting the state vector into the jackpot odds adjustment engine to calculate a personalized probability modifier using a non-linear weighting function;
dynamically re-weighting an acceptance range of a random number generator (RNG) by applying the personalized probability modifier to a base trigger threshold; and
executing the RNG using the re-weighted acceptance range to determine if a mystery jackpot event is triggered for the player, thereby technically modifying the probability of the mystery jackpot event based on the real-time player activity metrics.

18. The system of claim 17, wherein the first server system is further operable for determining a time-limited jackpot activation window that is available only to players having a VIP status above a predefined tier.

19. The system of claim 18, wherein the first server system is further operable for locking a set of non-qualifying player terminals out of the time-limited jackpot activation window.

20. The system of claim 17, wherein the personalized probability modifier increases the probability of the player winning the mystery jackpot event as a play frequency of the player increases.

21. The system of claim 17, wherein the first server system is further operable for dynamically granting the player access to a higher-value jackpot pool only upon the player reaching a VIP status above a predefined threshold.

22. The system of claim 17, wherein the first server system, in response to the mystery jackpot event being triggered, is further operable for calculating a payout amount and applying a VIP-based multiplier to the payout amount based on the VIP status of the player.

23. The system of claim 17, wherein the plurality of electronic table game terminals are connected across a multi-casino progressive network managed by the first server system.

24. The system of claim 17, wherein the personalized probability modifier is generated by the jackpot odds adjustment engine analyzing a historical win/loss ratio of the player.

25. A system for managing a spatially-aware progressive jackpot in a networked electronic table game environment, the system comprising:
a live dealer table;
a plurality of electronic table game terminals located at the live dealer table, each electronic table game terminal being operable for receiving player wagers and being associated with a physical seating position, wherein each electronic table game terminal comprises an integrated proximity sensor array;
a physical proximity tracking system configured to maintain a real-time topology map of the physical seating positions of a plurality of active players based on signals from the integrated proximity sensor arrays;
a first server system comprising a processor, a wager contribution system and a player activity tracker, the first server system being operable for:
monitoring a count of concurrent active players placing wagers within a specific timeframe using the player activity tracker;
calculating a dynamic contribution rate using a logistic sigmoid function based on the count of concurrent active players to apply hysteresis and prevent rapid fluctuation of a growth rate of a shared progressive jackpot pool;
receiving a trigger signal for the shared progressive jackpot pool and identifying a primary jackpot winner at a triggering electronic table game terminal;
querying the real-time topology map to identify a set of verified adjacent electronic table game terminals physically proximate to the triggering electronic table game terminal;
validating a presence of an adjacent player at each of the verified adjacent electronic table game terminals using the signals from the integrated proximity sensor arrays; and
automatically distributing a portion of the shared progressive jackpot pool to the adjacent players at the verified adjacent electronic table game terminals based on the validating of the presence of the adjacent player.

26. The system of claim 25, wherein the shared progressive jackpot pool aggregates contributions from the plurality of electronic table game terminals running disparate game types.

27. The system of claim 25, wherein each of the adjacent players automatically receives a fixed percentage share of the shared progressive jackpot pool, regardless of whether the adjacent player was the primary jackpot winner.

28. The system of claim 25, wherein the primary jackpot winner receives a first percentage share of the shared progressive jackpot pool and the adjacent players collectively receive a second percentage share of the shared progressive jackpot pool.

29. The system of claim 25, wherein the plurality of electronic table game terminals are networked across multiple distinct casino properties.

30. The system of claim 25, wherein the first server system is further operable for calculating the portion of the shared progressive jackpot pool for each of the adjacent players based on a cumulative wager contribution of the adjacent player to the shared progressive jackpot pool over a predefined period.

31. The system of claim 25, wherein the calculating of the dynamic contribution rate is achieved by increasing a percentage of each player's wager contributed to the shared progressive jackpot pool.
